(19) United States
(12) Patent Application Publication
(10) Pub. No.: US 2006/0183625 A1
(43) Pub. Date: Aug. 17, 2006

(54) Substrate for forming thin film, thin film substrate, optical wave guide, luminescent element and substrate for carrying luminescent element

(76) Inventor: Kenichiro Miyahara, Kanagawa (JP)

Correspondence Address: OMORI & YAGUCHI USA, LLC, EIGHT PENN CENTER, SUITE 1901, 1628 JOHN F. KENNEDY BOULEVARD, PHILADELPHIA, PA, 19103, US

(21) Appl. No.: 10/516,849

(22) PCT Filed: Jul. 4, 2003
(86) PCT No.: PCT/JP03/08520

§ 371 Date: Jan. 7, 2005

(30) Foreign Application Priority Data
Jul. 9, 2002 (JP) 2002-199567
Jul. 24, 2002 (JP) 2002-215336
Sep. 18, 2002 (JP) 2002-271053
Sep. 18, 2002 (JP) 2002-271061
Oct. 15, 2002 (JP) 2002-300848
Nov. 1, 2002 (JP) 2002-320048
Nov. 15, 2002 (JP) 2002-340619
Dec. 13, 2002 (JP) 2003-362783
Jun. 30, 2003 (JP) 2003-186175
Jun. 30, 2003 (JP) 2003-186373

(51) Int. Cl. C04B 35/00

(52) U.S. Cl. 501/98.4; 501/88; 501/97.1; 501/103; 501/120; 501/108; 501/127; 501/153; 501/152; 501/136; 501/137; 501/134

(57) ABSTRACT

It found out that a single crystal thin film which is excellent in crystallinity and comprises as the main ingredients at least one of more materials selected from a gallium nitride, an indium nitride, and an aluminum nitride can form on a substrate of a sintered compact which comprises as the main ingredients an aluminum nitride, a ceramic material having the crystal structure of a hexagonal system or a trigonal system, and a ceramic material having optical permeability. The above finding has allowed the preparation of a light emitting device excellent in luminous efficiency, an optical, waveguide exhibiting low loss, and a substrate for light emitting device mounting capable of controlling a direction of luminescence emitted to a substrate exterior.

### CROSSREFERENCE TO RELATED APPLICATIONS

This application is a continuation of PCT/JP2003/008520, filed on Jul. 4, 2003, and is based upon and claims priorities of Japanese Patent Applications Nos. 2002-199567, filed Jul. 9, 2002, 2002-215336, filed Jul. 24, 2002, 2002-271053, filed Sep. 18, 2002, 2002-271061, filed Sep. 18, 2002, 2002-300848, filed Oct. 15, 2002, 2002-320048, filed Nov. 1, 2002, 2002-340619, filed Nov. 25, 2002, 2002-362783, Dec. 13, 2002, 2003-186175, filed Jun. 30, 2003, and 2003-186373, filed Jun. 30, 2003, the contents being incorporated herein by reference.

### TECHNICAL FIELD

This invention relates to a substrate for forming a thin film which comprises a gallium nitride, an indium nitride, and an aluminum nitride as the main ingredient(s), a material for use in the formation of the above-mentioned substrate for thin film formation, an optical waveguide constituted with the thin film which comprises a gallium nitride, an indium nitride, and an aluminum nitride as the main ingredient(s), a light emitting device constituted with the thin film which comprises a gallium nitride, an indium nitride, and an aluminum nitride as the main ingredient(s), and a substrate for mounting a light emitting device.

### BACKGROUND ART

In recent years, various light emitting semiconductor devices, such as a light emitting diode (LED) or a laser diode (LD), came to be used for a light source of display, luminaire, optical communication, and storage apparatus, etc.

In such light emitting semiconductor devices, a device which emits light in a green and blue color—a blue color—a purple and blue color—ultraviolet rays has been developed growing epitaxially mainly of the III-V group nitride thin film which comprises at least one or more materials selected from the group consisting of a gallium nitride, an indium nitride, and an aluminum nitride as the main ingredient(s) and which is constituted with at least three or more layers of the III-V group nitride single crystal thin film layers which were semiconductor-ized into P and N type by doping and the luminescence layer, such as quantum well structure, onto a substrate, such as sapphire.

The above-mentioned light emitting device which consists of a III-V group nitride semiconductor which comprises at least one or more materials selected from the group consisting of a gallium nitride, an indium nitride, and an aluminum nitride as the main ingredient(s) and is constituted with at least three or more layers of a P type semiconductor layer, an N type semiconductor layer, and a luminescence layer (unless reference is made especially, henceforth, in this invention, it is only called a “light emitting device”) is used for the light sources of a signal, a backlight for liquid crystal, and a common lighting which replaces a fluorescent lamp and an incandescent lamp, etc., or the laser light source of a high capacity optical disk device, etc.

By an intended use, using the light from a light emitting device as it is, or using a phosphor, it changes into white light by an interaction, and is used.

This light emitting device has two terminal device (diode) construction constituted with the P type semiconductor, N-type semiconductor, and luminescence layer of above-mentioned each nitride or each nitride mixed crystal, and is driven applying direct current power.

High output-ization of a light emitting device has started, using such a light emitting device as a light source of high-output laser, or using as a light source of common lighting, etc.

When it is going to use a light emitting device for such an intended use, as for the substrate for forming a thin film which comprises an epitaxial film as the main substance and which comprises at least one or more materials selected from the group consisting of a gallium nitride, an indium nitride, and an aluminum nitride as the main ingredient(s) and constitutes a light emitting device, problems are arising.

That is, even if the conventional sapphire substrate is a single crystal, a crystal structure and a thermal expansion coefficient etc. differ from a gallium nitride, an indium nitride, and an aluminum nitride which constitute a light emitting device, therefore, the thin film which comprises at least one or more materials selected from the group consisting of a gallium nitride, an indium nitride, and an aluminum nitride as the main ingredient(s) and is formed on a sapphire cannot become into good crystallinity easily, it has been able to form as a single crystal thin film with high crystallinity by research in recent years at last.

However, since it is easy to generate a crystal dislocation and a strain in this thin film by the crystal lattice mismatching, or the difference of thermal expansion coefficient between the sapphire substrate and the thin film, even if it is a single crystal thin film with high crystallinity, manufacture yield of the light emitting device manufactured using such a thin film tends to be lowered, and achievement of the improvement in luminous efficiency of a light emitting device or improvement in characteristics, such as high-output-izing and long-life of a laser oscillation, is also difficult.

Moreover, since a sapphire substrate is a single crystal, manufacture cost is also highly, and there is a problem in which it can be hard to use for an extensive use the single crystal thin film which comprises at least one or more materials selected from the group consisting of a gallium nitride, an indium nitride, and an aluminum nitride as the main ingredient(s) and is formed on it.

Moreover, on the other hand, as for the optical waveguides for conducting the light from a light emitting device according to this invention, or from the conventional laser diode and light emitting diode, in desired intensity, distance, and a position, various things have been proposed hitherto.

Usually, it is obtained forming the high refractive index portion in crystal substrates, such as LiNbO₃ and silicon, or in glass substrates, such as silica glass.

As for conventional optical waveguides, there are problems, such that it has low permeability to the light with short wavelength, such as blue light and ultraviolet rays, or it is hard to form an electrical circuit simultaneously on the substrate in which an optical waveguide is formed because the electric insulation of a substrate is small, or it is hard to mount simultaneously a high-output light emitting device on the substrate in which an optical waveguide is formed because the thermal conductivity of a substrate is low, etc.

As mentioned above, when using a conventional sapphire substrate, the thin film which comprises at least one or more materials selected from the group consisting of a gallium nitride, an indium nitride, and an aluminum nitride as the main ingredient(s) and is formed on it has become to be able to be formed as a single crystal thin film with comparatively high crystallinity in recent years.

However, when using a sapphire substrate, the luminous efficiency of the light emitting device constituted mainly with such a thin film is low and is usually about 2%-8%, so 92% -98% of the electric power applied to a device is consumed other than the radiant power output to the device exterior, and the light emitting characteristics in which the III-V group nitride semiconductor originally has have not been shown sufficiently.

As the cause, it is easy to produce crystal dislocation and a distortion in the thin film by the crystal lattice mismatching, or the difference of thermal expansion coefficient between the sapphire substrate and this thin film even if the thin film which constitutes a light emitting device is able to be formed on a sapphire substrate as a single crystal thin film with high crystallinity, furthermore, it seems that many of light emitted from the light emitting device are reflected at the interface of the sapphire substrate and the above-mentioned thin film, or at the surface of a sapphire substrate, and are easy to be shut up by being returned into the inside of a light emitting device because the refractive index of a sapphire substrate is still smaller than a thin film of a gallium nitride, an indium nitride, and an aluminum nitride, moreover, a sapphire substrate is a transparent and homogeneous bulk single crystal.

Therefore, about the substrate material for manufacturing a light emitting device by forming the thin film which comprises at least one or more materials selected from the group consisting of a gallium nitride, an indium nitride, and an aluminum nitride as the main ingredient(s) and includes an epitaxial film, there have been proposals of the single crystal substrate materials which comprise silicon carbide, silicon, etc. as the main ingredients instead of conventional sapphire.

It is considered as the example using silicon carbide single crystal as a substrate, for example, methods, such as JP, 10-27947,A or JP,11-40884,A, are proposed.

Methods, such as JP, 10-214959,A, are proposed as silicon substrate.

However, even if these substrates are used, a good single crystal thin film is hard to be formed on these substrates for the reasons of a difference of crystal structure and lattice constant between the substrates and the single crystal thin film which comprises at least one or more materials selected from the group consisting of a gallium nitride, an indium nitride, and an aluminum nitride as the main ingredient(s).

Furthermore, in order to solve the problem in which the conventional single crystal substrates have, in JP,9-172199,A, the method of using the glass substrates, such as quartz glass, and the substrates produced by the sintering process, such as polycrystalline silicon, is proposed instead of the single crystal substrates.

However, this method must form the film material which consists of an oxide of II group elements, such as a zinc oxide and mercury oxide, before forming a gallium nitride system compound semiconductor layer on a substrate, but that effect is not necessarily clarified.

When the substrate which formed the oxide of such an II group elements is used, the crystallinity of the thin film which constitutes the gallium nitride system compound semiconductor formed there is not necessarily clear, and there is no clearness about the characteristics such as luminous efficiency of the produced semiconductor device, and has not resulted in problem solving after all.

As mentioned above, although the substrate which can form a excellent single crystal thin film that comprises as the main ingredient(s) at least one or more materials selected from the group consisting of a gallium nitride, an indium nitride, and an aluminum nitride is being requested for instead of single crystal substrates, such as conventional sapphire and a silicon carbide, such substrate has not realized yet.

Moreover, as for the thin film substrate which formed the above-mentioned excellent single crystal thin film which comprises at least one or more materials selected from the group consisting of a gallium nitride, an indium nitride, and an aluminum nitride as the main ingredient(s), it is being requested, however, such thin film substrate has not realized yet.

Thus, the luminous efficiency of the light emitting device which is made using a conventional sapphire substrate is low, so it is hard to say that the original luminescence characteristics of III-V group nitride semiconductor can be shown sufficiently, though the thing in which the luminous efficiency is equivalent or more to the light emitting device produced using a sapphire substrate is requested, the luminous efficiency of the light emitting device produced using substrates proposed by replacing a sapphire substrate in order to improve the fault of a sapphire substrate has not improved as mentioned above, and there was a problem in which the original luminescence characteristics of III-V group nitride semiconductor have not realized yet sufficiently.

On the other hand, the method indicated in the JP patent of No. 3119965 as an optical waveguide for leading a light with short wavelength, such as blue light and ultraviolet rays from a light emitting device, in desired intensity, distance, and a location, is proposed. In this proposal, although the method of forming the optical waveguide by an aluminum nitride thin film in the single crystal substrate which consists of silicon, sapphire, etc. is indicated, in order to obtain the waveguide nature of light with short wavelength, such as blue light and ultraviolet rays, the buffer layer which consists of an aluminum oxynitride, sialon, etc. needs to provide.

As the reason of such a device, because there is a mismatching of crystal lattice, or a difference of thermal expansion coefficient between the silicon and sapphire of the substrate material and the aluminum nitride, it is probably surmised that it will be because formation of an aluminum nitride thin film with high crystallinity is difficult, and transmission loss of a waveguide becomes large as a result.

Moreover, other than the mismatching of crystal lattice, and the difference of thermal expansion coefficient, when the silicon substrate is used, it seems a big cause that it does not function as a waveguide too, since a total reflection of light does not occur in the aluminum nitride thin film because the refractive index of an aluminum nitride thin film formed directly is small if it is compared with a silicon.

Furthermore, since electric insulation nature is small and the dielectric constant is high when silicon is used for a substrate, it can be hard to form an electrical circuit on a substrate directly, and there is a problem in which it can be hard to mount a light emitting device on a substrate unitedly.

Moreover, since the thermal conductivity is small when using a sapphire for a substrate, in case a high-output light emitting device is mounted, a problem arises in a nature of radiating heat.

Therefore, there were problems, such that the satisfactory optical waveguide which transmits a light with short wavelength, such as blue light and ultraviolet rays, from a light emitting device and which forms an electric circuit for driving a device and can mount a high power light emitting device has not been realized.

Furthermore, on the other hand, when actually using the above-mentioned light emitting device for the light source of high-output laser, or the light source of common lighting, in order not to spoil the original performance of this light emitting device as much as possible, the characteristics of the substrate which mounts or packages the light emitting device are also important.

Until now, although a substrate sealed with resin and a metal substrate have been used as a substrate which mounts a light emitting device or packages it, there are problems, such that it is hard to emit the luminescence output from a high-output light emitting device to the substrate exterior efficiently or to control the luminescence direction, etc.

When it is going to use a light emitting device for such use, especially the light source for common lighting, what is easy to emit luminescence emitted from the light emitting device into all directions of the substrate exterior efficiently without loss as much as possible, what is easy to radiate generation of heat from a light emitting device to the substrate exterior, what is possible to mount a large-sized device accompanying high-output-izing, the thing in which the junction nature between a light emitting device and a substrate is maintained even if the thermal shock is performed by the drive of a light emitting device, and the thing in which the compact circuitry, such as providing multilevel interconnection in the inside of a substrate, is possible, etc., are desirable as a substrate for light emitting device mounting.

Until now, substrates devised in order not to spoil luminescence from a light emitting device as much as possible as a substrate for mounting a light emitting device, and to emit a luminescence efficiently to the outside of the substrate have been used.

For example, in the JP patent of No. 3065258, a light emitting device is mounted on the metal lead, such as copper, or plastic substrate which form the portion for containing and are made to emit light, luminescence emitted from the portion for containing is emitted to the outside efficiently by the reflective portion formed beforehand.

Moreover, for example, in the JP patent of No. 3256951, an aluminum substrate which is covered with the thin film insulator, such as alumite which reflects the light from a light emitting device, or a white ceramics are proposed as a substrate for light emitting device mounting, and are used.

Such a conventional aluminum substrate etc. can emit the light from a light emitting device efficiently to the outside by raising a condensing nature of the light from a light emitting device into the specific direction.

Conventional substrates for light emitting device mounting have high effect, when emitting the light from a light emitting device into the specific direction, such as an object for the backlight of liquid crystal.

However, when it is using a light emitting device as a light source which replaces an incandescent lamp or a fluorescent lamp, etc. like common lighting, emitting efficiently the luminescence from the light emitting device to the space of all the directions is required.

In such case, it cannot be said that the conventional substrate for light emitting device mounting is suitable.

Furthermore, in the case of the above-mentioned aluminum covered with an alumite, for example, the thermal expansion coefficient differs from gallium nitride, indium nitride, and aluminum nitride which are the main ingredient(s) of a light emitting device, aluminum is intolerable to the stress at the time of sudden thermal shock of the light emitting device accompanying high-output-izing, and the mounting of a large-sized light emitting device is difficult for it.

In the case of the substrate using the aluminum covered with the alumite, since the electric wiring formed on this substrate has small adhesive strength with a substrate and tends to exfoliate, so it can be hard to perform attachment of the light emitting device by adhesives etc. on the wiring, furthermore, since the electric wiring was not able to be formed in the inside of a substrate, the electric wiring must be formed only on the surface alumite portion, and there were faults, such that the restriction arose in the substrate design and the miniaturization of a substrate cannot be performed easily.

As a substrate for mounting a high-output light emitting device, what can satisfy simultaneously characteristics, such as a light emitting nature to the exterior, a direction controllability of emitting light, a nature of radiating heat, a nature of miniaturizing circuitry, a mounting nature of a large-sized light emitting device, and a junction reliability between a light emitting device and a substrate, etc., has not yet obtained as mentioned above, especially, a development of the substrate with the above-mentioned characteristics which are not in a conventional substrate has been called for in order to realize the light source for common lighting and light source for high-output laser which will develop greatly from now on.

### DISCLOSURE OF THE INVENTION

This invention is made in order to solve the problems described above.

This inventor has examined various sintered compacts which comprise a ceramic material as the main ingredients, mainly an aluminum nitride, as the substrate for forming a single crystal thin film which comprises at least one or more materials selected from the group consisting of a gallium nitride, an indium nitride, and an aluminum nitride as the main ingredient(s).

Among them, especially it found out the direct formation of a single crystal thin film which is excellent in crystallinity and comprises as the main ingredient(s) at least one or more materials selected from the group consisting of a gallium nitride, an indium nitride, and an aluminum nitride can be carried out using the substrate which consists of a sintered compact which comprises an aluminum nitride as the main ingredients, and it has proposed in the JP application for patent 2002-215336 and the JP application for patent 2003-186175.

As shown above, this time it found out that the thin film which comprises at least one or more materials selected from the group consisting of a gallium nitride, an indium nitride, and an aluminum nitride as the main ingredient(s) and are not necessarily the epitaxially grown single crystal thin film, such as an amorphous thin film, a polycrystalline thin film, and an orientated polycrystalline thin film, can be formed directly on the various sintered compacts which can form a single crystal thin film and comprise ceramics, such as an aluminum nitride, as the main ingredients.

Furthermore, using the sintered compact which comprises an aluminum nitride as the main ingredients and which formed beforehand the thin film of such various crystallized states, as a substrate, if the single crystal thin film which comprises as the main ingredient(s) at least one or more materials selected from the group consisting of a gallium nitride, an indium nitride, and an aluminum nitride is grown on this substrate, it found out that the single crystal thin film obtained excelled in crystallinity the single crystal thin film which formed directly on the sintered compact which comprises an aluminum nitride as the main ingredients.

Thus, in this invention, it was found out that the single crystal thin film excellent in crystallinity which comprises as the main ingredient(s) at least one or more materials selected from the group consisting of a gallium nitride, an indium nitride, and an aluminum nitride can be formed on the sintered compact which comprises an aluminum nitride as the main ingredients, and it was found out that the thin film substrate which formed the single crystal thin film excellent in crystallinity which comprises as the main ingredients at least one or more materials selected from the group consisting of a gallium nitride, an indium nitride, and an aluminum nitride can be obtained using the sintered compact which comprises an aluminum nitride as the main ingredients.

Using the sintered compact which comprises an aluminum nitride as the main ingredients and which does not form the above-mentioned thin film, and the thin film substrate in which the thin film which comprises as the main ingredient(s) at least one or more materials selected from the group consisting of a gallium nitride, an indium nitride, and an aluminum nitride was formed on the above-mentioned sintered compact which comprises an aluminum nitride as the main ingredients, the light emitting device in which the luminous efficiency is at least equivalent or more or is a maximum of not less than 4-5 times can be produced if it is compared with the light emitting device produced using the conventional sapphire substrate.

Furthermore, using the above-mentioned thin film substrate, it became clear that the optical waveguide in which the transmission loss is small and which can transmit ultraviolet light in low loss can be manufactured.

In addition, this inventor found out that the thin film which comprises as the main ingredient(s) at least one or more materials selected from the group consisting of a gallium nitride, an indium nitride, and an aluminum nitride can be formed on the sintered compact which comprises as the main ingredients a ceramic material which has the crystal structure of a hexagonal system or a trigonal system, such as a silicon carbide, a silicon nitride, a beryllium oxide, a zinc oxide, and aluminum oxide etc., and that the single crystal thin film which is excellent in crystallinity and comprises as the main ingredient(s) at least one or more materials selected from the group consisting of a gallium nitride, an indium nitride, and an aluminum nitride can be formed using the sintered compact of a specific surface state or surface roughness, even if it does not have the intermediate oxide film material of II group elements, such as mercury oxide etc.

Moreover, as for the thing in which the thin film which comprises as the main ingredient(s) at least one or more materials selected from the group consisting of a gallium nitride, an indium nitride, and an aluminum nitride was formed beforehand on the above-mentioned sintered compact which comprises as the main ingredients a ceramic material which has the crystal structure of a hexagonal system or a trigonal system, it found out that the single crystal thin film which is more excellent in crystallinity could be formed on it.

Moreover, among the above-mentioned sintered compacts which comprise as the main ingredients a ceramic material which has the crystal structure of a hexagonal system or a trigonal system, it found out that the thing which comprises a beryllium oxide, a zinc oxide, and an aluminum oxide as the main ingredients and which has specific composition was excellent for forming a single crystal thin film.

Moreover, since the thing excellent in optical permeability can be obtained, it found out that it is desirable as a substrate for producing a light emitting device.

As for the above-mentioned sintered compact which comprises a zinc oxide as the main ingredients, since what contains an aluminum ingredient has electrical conductive nature and optical permeability, it was found out that the light emitting device excellent in luminous efficiency can be produced by a simple manufacturing process if using such sintered compact which comprises a zinc oxide as the main ingredients.

This invention includes the substrate for thin film formation which consists of the sintered compact which comprises as the main ingredients a ceramic material which has the crystal structure of a hexagonal system or a trigonal system, such as a silicon carbide, a silicon nitride, a beryllium oxide, a zinc oxide, and an aluminum oxide etc.

And this invention also includes the thin film substrate in which the thin film which comprises as the main ingredient(s) at least one or more materials selected from the group consisting of a gallium nitride, an indium nitride, and an aluminum nitride is formed on the substrate which consists of a sintered compact which comprises as the main ingredients a ceramic material which has the crystal structure of a hexagonal system or a trigonal system.

This invention include the light emitting device produced using the sintered compact which comprises as the main ingredients a ceramic material which has the crystal structure of a hexagonal system or a trigonal system, such as a silicon carbide, a silicon nitride, a beryllium oxide, a zinc oxide, and an aluminum oxide etc., or the light emitting device produced using a sintered compact which formed beforehand the thin film comprising at least one or more materials selected from the group consisting of a gallium nitride, an indium nitride, and an aluminum nitride as the main ingredient(s) and which comprises as the main ingredients a ceramic material which has the crystal structure of a hexagonal system or a trigonal system, such as a silicon carbide, a silicon nitride, a beryllium oxide, a zinc oxide, etc., and an aluminum oxide etc.

And, this inventor found out that the light emitting device in which the luminous efficiency is equivalent or more at least or is a maximum of not less than 3-4 times can be manufactured if it is compared with the light emitting device produced using a sapphire substrate.

In addition to this, the sintered compact which comprises as the main ingredients a zirconium oxide, a magnesium oxide, a magnesium aluminate, a titanium oxide, a barium titanate, a lead titanate zirconate, and rare-earth oxides for example a yttrium oxide, a thorium dioxide, various ferrites, mullite, forsterite, steatite, and glass ceramics, etc. can produce what has optical permeability comparatively easily.

And, this inventor found out that what formed beforehand the thin film which comprises as the main ingredients at least one or more materials selected from a gallium nitride, an indium nitride, and an aluminum nitride onto the sintered compact can form the single crystal thin film excellent in crystallinity.

This invention includes the above substrate for thin film formation characterized by a sintered compact which has optical permeability and comprises as the main ingredients a ceramic material, such as a zirconium oxide, a magnesium oxide, a magnesium aluminate, a titanium oxide, a barium titanate, a lead titanate zirconate, and rare-earth oxides for example a yttrium oxide, a thorium dioxide, various ferrites, mullite, forsterite, steatite, and glass ceramics etc.

And, this invention also includes a thin film substrate in which a thin film which comprises as the main ingredient(s) at least one or more materials selected from the group consisting of a gallium nitride, an indium nitride, and an aluminum nitride is formed on the sintered compact which has optical permeability and comprises as the main ingredients a ceramic material, such as a zirconium oxide, a magnesium oxide, a magnesium aluminate, a titanium oxide, a barium titanate, a lead titanate zirconate, and rare-earth oxides for example a yttrium oxide, a thorium dioxide, various ferrites, mullite, forsterite, steatite, and glass ceramics etc.

This invention includes such light emitting device produced using a sintered compact which formed beforehand the thin film comprising at least one or more materials selected from the group consisting of a gallium nitride, an indium nitride, and an aluminum nitride as the main ingredient(s) and which has optical permeability and comprises as the main ingredients a ceramic material, such as a zirconium oxide, a magnesium oxide, a magnesium aluminate, a titanium oxide, a barium titanate, a lead titanate zirconate, and rare-earth oxides for example a yttrium oxide, a thorium dioxide, various ferrites, mullite, forsterite, steatite, and glass ceramics, etc.

And, this inventor also found out that the light emitting device in which the luminous efficiency is equivalent or more at least or is a maximum of not less than 2-3 times can be manufactured if it is compared with the light emitting device produced using a sapphire substrate.

Furthermore, this inventor has examined a substrate for light emitting device mounting using the various sintered compacts which comprise a ceramic material as the main ingredients, as a substrate for mounting a light emitting device, in order to have an nature excellent in radiating heat or in electric insulation, to be easy to design compactly the electric circuit for making a light emitting device drive, to be able to mount the large-sized light emitting device, and to raise the junction reliability between a light emitting device and a substrate furthermore.

Consequently, it was found that the above-mentioned sintered compact which comprises an aluminum nitride as the main ingredients is able to show a good characteristic not only as the substrate for thin film formation but also as a substrate for mounting the light emitting device.

That is, as for the sintered compact which comprises an aluminum nitride as the main ingredients, it was found out that it has high thermal conductivity, that the thermal expansion coefficient is close to a light emitting device, and that what has good optical permeability is obtained.

And, it was found out that the light from the light emitting device is emitted efficiently to the substrate exterior not only from the substrate surface side on which a light emitting device is mounted but also from the opposite substrate surface side by penetrating a substrate by using the optical permeability of the sintered compact which comprises an aluminum nitride as the main ingredients.

It was also found out that the luminescence from a light emitting device can be emitted into the arbitrary direction of circumference space of the substrate including the opposite substrate surface on which a light emitting device is being mounted or contained, and that a substrate for light emitting device mounting which consists of a sintered compact which comprises an aluminum nitride as the main ingredients and which can also control the direction of luminescence from a light emitting device is obtained.

A reflective prevention material or a reflective material can be formed in the sintered compact which comprises an aluminum nitride as the main ingredients.

It found that it is also possible to emit efficiently the light from a light emitting device mounted into the specific direction of circumference space of the substrate when the sintered compact which comprises an aluminum nitride as the main ingredients and in which a reflective prevention material or a reflective material are formed is used as a substrate for light emitting device mounting.

Furthermore, when the sintered compact which comprises an aluminum nitride as the main ingredients is used as a substrate for light emitting device mounting, it was easy to radiate generation of heat from a light emitting device to the substrate exterior, and it found out that there was the feature of being easy to design the electrical circuit furthermore compactly for driving a light emitting device using multilayered metallizing, and thin film metallizing, etc.

This inventor has completed this invention, as a result of investigating wholeheartedly as mentioned above.

That is, this invention is a substrate for thin film formation in which a thin film comprises at least one or more materials selected from the group consisting of a gallium nitride, an indium nitride, and an aluminum nitride as the main ingredient(s), and the substrate consists of a sintered compact which comprises an aluminum nitride as the main ingredients.

And, this invention is a substrate for thin film formation in which a thin film comprises at least one or more materials selected from the group consisting of a gallium nitride, an indium nitride, and an aluminum nitride as the main ingredient(s), and the substrate consists of a sintered compact which comprises as the main ingredients a ceramic material which has at least one of the crystal structures selected from a hexagonal system or a trigonal system.

And, this invention is a substrate for thin film formation in which a thin film comprises at least one or more materials selected from the group consisting of a gallium nitride, an indium nitride, and an aluminum nitride as the main ingredient(s), and the substrate consists of a sintered compact which comprises a ceramic material as the main ingredients and which has optical permeability.

And, this invention is a manufacture method of the substrate for thin film formation in which a thin film comprises at least one or more materials selected from the group consisting of a gallium nitride, an indium nitride, and an aluminum nitride as the main ingredient(s), and the substrate consists of a sintered compact which comprises an aluminum nitride as the main ingredients, the method comprises using as a raw material at least one of raw materials using respectively alone of either which is selected from what is made by reduction of an aluminum oxide and what is made by direct nitriding of metal aluminum, or using the mixture of what is made by reduction of an aluminum oxide and what is made by direct nitriding of metal aluminum, to form the sintered compact.

And, this invention is a manufacture method of the substrate for thin film formation in which a thin film comprises at least one or more materials selected from the group consisting of a gallium nitride, an indium nitride, and an aluminum nitride as the main ingredient(s), and the substrate consists of a sintered compact which comprises an aluminum nitride as the main ingredients, the method comprises firing the powder compact or sintered compact which comprise an aluminum nitride as the main ingredients for not less than 10 minutes at the temperature not less than 1500 degrees C. in non-oxidizing atmosphere to form the sintered compact.

And, this invention is a sintered compact which comprises an aluminum nitride as the main ingredients, in which the content of at least one or more ingredients selected from a rare earth element and an alkaline-earth metal is a total of not more than 0.5 weight % by element conversion, oxygen content is not more than 0.9 weight % by element conversion, AlN is not less than 95% as a crystal phase, the size of an aluminum nitride particle is not less than 5 μm, and having optical permeability.

And, this invention is a sintered compact which comprises a zinc oxide as the main ingredients and contains an aluminum ingredient at least and which has optical permeability.

And, this invention is a thin film substrate in which the thin film comprises at least one or more materials selected from the group consisting of a gallium nitride, an indium nitride, and an aluminum nitride as the main ingredient(s), and is formed on the sintered compact which comprises an aluminum nitride as the main ingredients.

And, this invention is a thin film substrate in which the thin film comprises at least one or more materials selected from the group consisting of a gallium nitride, an indium nitride, and an aluminum nitride as the main ingredient(s), and is formed on the sintered compact which comprises as the main ingredients a ceramic material which has at least one of the crystal structures selected from a hexagonal system or a trigonal system.

And, this invention is a thin film substrate in which the thin film comprises at least one or more materials selected from the group consisting of a gallium nitride, an indium nitride, and an aluminum nitride as the main ingredient(s), and is formed on the sintered compact which comprises a ceramic material as the main ingredients and which has optical permeability.

And, this invention is a thin film substrate in which an optical waveguide is formed on the sintered compact which comprises an aluminum nitride as the main ingredients by the thin film which comprises at least one or more materials selected from the group consisting of a gallium nitride, an indium nitride, and an aluminum nitride as the main ingredient(s).

And, this invention is a manufacture method of a thin film substrate in which a thin film which comprises at least one or more materials selected from the group consisting of a gallium nitride, an indium nitride, and an aluminum nitride as the main ingredient(s) is formed on the sintered compact which comprises an aluminum nitride as the main ingredients, and the thin film is formed using the organic compound of at least one or more elements selected from gallium, indium, and aluminum as a main raw material and using at least one or more elements selected from ammonia, nitrogen, and hydrogen as a reactive gas.

And, this invention is a manufacture method of a thin film substrate in which a thin film which comprises at least one or more materials selected from the group consisting of a gallium nitride, an indium nitride, and an aluminum nitride as the main ingredient(s) is formed on the sintered compact which comprises an aluminum nitride as the main ingredients, and the thin film is formed using the halogenated compound of at least one or more elements selected from gallium, indium, and aluminum as a main raw material and using at least one or more elements selected from ammonia, nitrogen, and hydrogen as a reactive gas.

And, this invention is a manufacture method of a thin film substrate in which a thin film which comprises at least one or more materials selected from the group consisting of a gallium nitride, an indium nitride, and an aluminum nitride as the main ingredient(s) is formed on the sintered compact which comprises as the main ingredients a ceramic material which has at least one of the crystal structures selected from a hexagonal system or a trigonal system, and the thin film is formed using the organic compound of at least one or more elements selected from gallium, indium, and aluminum as a main raw material and using at least one or more elements selected from ammonia, nitrogen, and hydrogen as a reactive gas.

And, this invention is a manufacture method of a thin film substrate in which a thin film which comprises at least one or more materials selected from the group consisting of a gallium nitride, an indium nitride, and an aluminum nitride as the main ingredient(s) is formed on the sintered compact which comprises a ceramic material as the main ingredients and which has optical permeability, and the thin film is formed using the organic compound of at least one or more elements selected from gallium, indium, and aluminum as a main raw material and using at least one or more elements selected from ammonia, nitrogen, and hydrogen as a reactive gas.

And, this invention is an optical waveguide which comprises at least one or more materials selected from the group consisting of a gallium nitride, an indium nitride, and an aluminum nitride as the main ingredient(s) and which contains at least one or more ingredients which are selected from niobium and tantalum.

And, this invention is an optical waveguide which consists of a bulk single crystal which comprises at least one or more materials selected from the group consisting of a gallium nitride, an indium nitride, and an aluminum nitride as the main ingredient(s).

And, this invention is a light emitting device constituted by laminating the N type semiconductor layer, luminescence layer, and P type semiconductor layer which consist of a thin film which comprises at least one or more materials selected from the group consisting of a gallium nitride, an indium nitride, and an aluminum nitride as the main ingredient(s), and the laminated body of N type semiconductor layer, luminescent layer, and P type semiconductor layer is being formed on the sintered compact which comprises an aluminum nitride as the main ingredients.

And, this invention is a light emitting device constituted by laminating the N type semiconductor layer, luminescence layer, and P type semiconductor layer which consist of a thin film which comprises at least one or more materials selected from the group consisting of a gallium nitride, an indium nitride, and an aluminum nitride as the main ingredient(s), and the laminated body of N type semiconductor layer, luminescent layer, and P type semiconductor layer is being formed on the sintered compact which comprises as the main ingredients a ceramic material which has at least one of the crystal structures selected from a hexagonal system or a trigonal system.

And, this invention is a light emitting device constituted by laminating the N type semiconductor layer, luminescence layer, and P type semiconductor layer which consist of a thin film which comprises at least one or more materials selected from the group consisting of a gallium nitride, an indium nitride, and an aluminum nitride as the main ingredient(s), and the laminated body of N type semiconductor layer, luminescent layer, and P type semiconductor layer is being formed on the sintered compact which comprises a ceramic material as the main ingredients and which has optical permeability.

And, this invention is a substrate for light emitting device mounting in which a light emitting device comprises at least one or more materials selected from the group consisting of a gallium nitride, an indium nitride, and an aluminum nitride as the main ingredient(s), and the substrate consists of a sintered compact which comprises an aluminum nitride as the main ingredients and which has optical permeability.

And, this invention is a substrate for light emitting device mounting in which a light emitting device comprises at least one or more materials selected from the group consisting of a gallium nitride, an indium nitride, and an aluminum nitride as the main ingredient(s), and the substrate consists of a sintered compact which comprises an aluminum nitride as the main ingredients and which formed the reflective prevention material.

And, this invention is a substrate for light emitting device mounting in which a light emitting device comprises at least one or more materials selected from the group consisting of a gallium nitride, an indium nitride, and an aluminum nitride as the main ingredient(s), and the substrate consists of a sintered compact which comprises an aluminum nitride as the main ingredients and which formed the reflective material.

And, this invention is a manufacture method of the substrate for light emitting device mounting in which a light emitting device comprises at least one or more materials selected from the group consisting of a gallium nitride, an indium nitride, and an aluminum nitride as the main ingredient(s), and the substrate consists of a sintered compact which comprises an aluminum nitride as the main ingredients, the method comprises using as a raw material at least one of raw materials using respectively alone of either which is selected from what is made by reduction of an aluminum oxide and what is made by direct nitriding of metal aluminum, or using the mixture of what is made by reduction of an aluminum oxide and what is made by direct nitriding of metal aluminum, to form the sintered compact.

And, this invention is a manufacture method of the substrate for light emitting device mounting in which a light emitting device comprises at least one or more materials selected from the group consisting of a gallium nitride, an indium nitride, and an aluminum nitride as the main ingredient(s), and the substrate consists of a sintered compact which comprises an aluminum nitride as the main ingredients, the method comprises firing the powder compact or sintered compact which comprise an aluminum nitride as the main ingredients for not less than 10 minutes at the temperature not less than 1500 degrees C. in non-oxidizing atmosphere to form the sintered compact.

### BRIEF EXPLANATION OF THE DRAWINGS

FIG. 1 is a drawing showing the substrate for thin film formation according to this invention and the crystal orientation of the single crystal thin film formed on that substrate.

FIG. 2 is a drawing showing the X-ray diffraction by the single crystal thin film formed on the substrate for thin film formation according to this invention.

FIG. 3 is a perspective diagram showing one example of the substrate for thin film formation with a conduction via according to this invention.

FIG. 4 is the drawing showing the substrate for thin film formation according to this invention and the crystal orientation of the single crystal thin film formed on the substrate.

FIG. 5 is a perspective diagram showing one example of the substrate for thin film formation and the thin film substrate according to this invention.

FIG. 6 is a perspective diagram showing one example of the thin film substrate according to this invention.

FIG. 7 is a perspective diagram showing one example of the substrate for thin film formation and the thin film substrate which have a conduction via according to this invention.

FIG. 8 is a perspective diagram showing one example of the thin film substrate with a conduction via according to this invention.

FIG. 9 is a diagram showing the optical transmissivity of the aluminum nitride sintered compact according to this invention.

FIG. 10 is a perspective diagram showing one example of the substrate for thin film formation according to this invention on which thin film conductivity material was formed.

FIG. 11 is a perspective diagram showing one example of the substrate for thin film formation according to this invention on which thin film conductivity material was formed.

FIG. 12 is a perspective diagram showing one example of the substrate for thin film formation with a conduction via according to this invention on which thin film conductivity material was formed.

FIG. 13 is a perspective diagram showing one example of the substrate for thin film formation according to this invention on which the thin film conductivity material of pattern form was formed.

FIG. 14 is a perspective diagram showing one example of the thin film substrate according to this invention on which the thin film which comprises as the main ingredients at least one or more materials selected from a gallium nitride, an indium nitride, and an aluminum nitride was formed on the thin film conductivity material.

FIG. 15 is a perspective diagram showing one example of the thin film substrate according to this invention on which the thin film conductivity material and the thin film which comprises as the main ingredients at least one or more materials selected from a gallium nitride, an indium nitride, and an aluminum nitride were formed respectively on the different surface.

FIG. 16 is a perspective diagram showing one example of the thin film substrate according to this invention on which the thin film which comprises as the main ingredients at least one or more materials selected from a gallium nitride, an indium nitride, and an aluminum nitride was formed on the thin film conductivity material and the thin film conductivity material was formed furthermore on the different surface.

FIG. 17 is a perspective diagram showing one example of the thin film substrate according to this invention on which the thin film conductivity material was formed on the thin film which comprises as the main ingredients at least one or more materials selected from a gallium nitride, an indium nitride, and an aluminum nitride.

FIG. 18 is a perspective diagram showing one example of the thin film substrate according to this invention on which the thin film which comprises as the main ingredients at least one or more materials selected from a gallium nitride, an indium nitride, and an aluminum nitride was formed on the thin film conductivity material which was formed beforehand on the sintered compact which comprises an aluminum nitride as the main ingredients then the thin film conductivity material was formed furthermore on it.

FIG. 19 is a perspective diagram showing one example of the thin film substrate according to this invention on which the thin film which comprises as the main ingredients at least one or more materials selected from a gallium nitride, an indium nitride, and an aluminum nitride was formed on the thin film conductivity material which was formed beforehand on the sintered compact with a conduction via which comprises an aluminum nitride as the main ingredients then the thin film conductivity material was formed furthermore on surface of the thin film.

FIG. 20 is a perspective diagram showing one example of the thin film substrate according to this invention on which the thin film which comprises as the main ingredients at least one or more materials selected from a gallium nitride, an indium nitride, and an aluminum nitride was formed furthermore on the sintered compact which comprises an aluminum nitride as the main ingredients and which formed beforehand the thin film conductivity material, and the thin film conductivity material was formed furthermore on the surface of the thin film.

FIG. 21 is a perspective diagram showing one example of the thin film substrate on which a two dimension optical waveguide is being formed on the sintered compact according to this invention which comprises an aluminum nitride as the main ingredients by the thin film which comprises as the main ingredients at least one or more materials selected from a gallium nitride, an indium nitride, and an aluminum nitride.

FIG. 22 is a perspective diagram showing one example of the thin film substrate according to this invention on which the cladding layer was formed on the two dimensional optical waveguide.

FIG. 23 is a perspective diagram showing one example of the thin film substrate according to this invention on which the two dimension optical waveguide was formed.

FIG. 24 is a perspective diagram showing one example of the thin film substrate according to this invention on which the three dimension optical waveguide was formed.

FIG. 25 is a perspective diagram showing one example of the thin film substrate according to this invention on which the three dimension optical waveguide was formed.

FIG. 26 is a perspective diagram showing one example of the thin film substrate according to this invention on which the ridge type three dimension optical waveguide was formed.

FIG. 27 is a perspective diagram showing one example of the thin film substrate according to this invention on which the three dimension optical waveguide was formed in the two dimension optical waveguide by forming dielectric materials in the two dimension optical waveguide.

FIG. 28 is a perspective diagram showing one example of the thin film substrate according to this invention on which the three dimension optical waveguide was formed in the two dimension optical waveguide by directly forming a metallic material in the two dimension optical waveguide.

FIG. 29 is a perspective diagram showing one example of the thin film substrate according to this invention on which the three dimension optical waveguide was formed by forming an electrode in the two dimension optical waveguide via a buffer layer and applying potential between these electrodes.

FIG. 30 is a perspective diagram showing one example of the thin film substrate according to this invention on which the three dimension optical waveguide of an embedded type is formed in the thin film which comprises as the main ingredients at least one or more materials selected from a gallium nitride, an indium nitride, and an aluminum nitride.

FIG. 31 is a perspective diagram showing one example of the thin film substrate according to this invention on which the three dimension optical waveguide of an embedded type and further the electrode are formed.

FIG. 32 is a perspective diagram showing one example of the thin film substrate according to this invention on which the three dimension optical waveguide of an embedded type and further the electrode are formed.

FIG. 33 is a perspective diagram showing one example of the thin film substrate according to this invention on which the three dimension optical waveguide of an embedded type and further the electrode are formed.

FIG. 34 is a perspective diagram showing one example of the thin film substrate according to this invention on which the three dimension optical waveguide and further the electrical circuit are formed.

FIG. 35 is a perspective diagram showing one example of the thin film substrate according to this invention on which the three dimension optical waveguide of an embedded type and further the electrical circuit are formed.

FIG. 36 is a perspective diagram showing one example of the substrate for thin film formation according to this invention.

FIG. 37 is a perspective diagram showing one example of the thin film substrate according to this invention on which the thin film which comprises as the main ingredients at least one or more materials selected from a gallium nitride, an indium nitride, and an aluminum nitride was formed on the thin film conductivity material.

FIG. 38 is a perspective diagram showing one example of the thin film substrate with a conduction via according to this invention on which the thin film which comprises as the main ingredients at least one or more materials selected from a gallium nitride, an indium nitride, and an aluminum nitride was formed on the thin film conductivity material.

FIG. 39 is a sectional drawing showing one example of the constitution of a light emitting device.

FIG. 40 is a sectional drawing showing one example of a light emitting device using a conventional substrate.

FIG. 41 is a sectional drawing showing one example of a light emitting device using a conventional substrate.

FIG. 42 is a sectional drawing showing one example of the light emitting device according to this invention.

FIG. 43 is a sectional drawing showing one example of the light emitting device according to this invention.

FIG. 44 is a sectional drawing showing one example of the light emitting device according to this invention.

FIG. 45 is a perspective diagram showing one example of the light emitting device according to this invention.

FIG. 46 is a perspective diagram showing one example of the light emitting device according to this invention.

FIG. 47 is a sectional drawing showing one example of the light emitting device according to this invention.

FIG. 48 is a sectional drawing showing one example of the light emitting device according to this invention.

FIG. 49 is a sectional drawing showing one example of the light emitting device according to this invention.

FIG. 50 is a sectional drawing showing one example of the light emitting device according to this invention.

FIG. 51 is a sectional drawing showing one example of the light emitting device according to this invention.

FIG. 52 is a sectional drawing showing one example of the light emitting device according to this invention.

FIG. 53 is a sectional drawing showing one example of the light emitting device according to this invention.

FIG. 54 is a sectional drawing showing one example of the light emitting device according to this invention.

FIG. 55 is a sectional drawing showing one example of the light emitting device according to this invention.

FIG. 56 is a sectional drawing showing one example of the light emitting device according to this invention.

FIG. 57 is a sectional drawing showing one example of the light emitting device according to this invention.

FIG. 58 is a sectional drawing showing one example of the light emitting device according to this invention.

FIG. 59 is a sectional drawing showing one example which guessed the situation of luminescence of the light emitting device according to this invention.

FIG. 60 is a perspective diagram showing one example which guessed the situation of luminescence of the light emitting device according to this invention.

FIG. 61 is a perspective diagram showing one example of the light emitting device according to this invention.

FIG. 62 is a figure showing one example of the X-ray diffraction pattern in case the crystallized state of an AlN thin film is amorphous.

FIG. 63 is a figure showing one example of an X-ray diffraction pattern in case the crystallized state of an AlN thin film is polycrystal.

FIG. 64 is a figure showing one example of an X-ray diffraction pattern in case the crystallized state of an AlN thin film is the orientated polycrystal formed in the direction where C axis is perpendicular to the substrate surface.

FIG. 65 is a figure showing one example of an X-ray diffraction pattern in case the crystallized state of an AlN thin film is the single crystal formed in the direction where C axis is perpendicular to the substrate surface.

FIG. 66 is a pattern showing one example of the rocking curve of X-ray diffraction line from the lattice plane of the Miller Index (002) measured by ω scan of the AlN single crystal thin film formed in the direction where C axis is perpendicular to the substrate surface.

FIG. 67 is a figure showing one example of an X-ray diffraction pattern in case the crystallized state of a GaN thin film is the single crystal formed in the direction where C axis is perpendicular to the substrate surface.

FIG. 68 is a figure showing one example of an X-ray diffraction pattern in case the crystallized state of an InN thin film is the single crystal formed in the direction where C axis is perpendicular to the substrate surface.

FIG. 69 is a sectional drawing showing one example of the light emitting device mounted on the substrate for light emitting device mounting according to this invention.

FIG. 70 is a sectional drawing showing one example of the light emitting device mounted on the substrate for light emitting device mounting according to this invention.

FIG. 71 is a sectional drawing showing one example of the substrate for light emitting device mounting according to this invention.

FIG. 72 is a sectional drawing showing one example of the substrate for light emitting device mounting according to this invention.

FIG. 73 is a sectional drawing showing one example of the substrate for light emitting device mounting according to this invention.

FIG. 74 is a sectional drawing showing one example of the substrate for light emitting device mounting according to this invention.

FIG. 75 is a sectional drawing showing one example of the substrate for light emitting device mounting according to this invention which has a conduction via.

FIG. 76 is a sectional drawing showing one example of the substrate for light emitting device mounting according to this invention which has a conduction via.

FIG. 77 is a sectional drawing showing one example of the substrate for light emitting device mounting according to this invention when having a submount.

FIG. 78 is a sectional drawing showing one example of the substrate for light emitting device mounting according to this invention when having a submount.

FIG. 79 is a sectional drawing showing one example of the substrate for light emitting device mounting according to this invention when having a submount.

FIG. 80 is a sectional drawing showing one example of the substrate for light emitting device mounting according to this invention when having a submount.

FIG. 81 is a sectional drawing showing one example of the substrate for light emitting device mounting according to this invention when having a submount.

FIG. 82 is a sectional drawing showing one example of the substrate for light emitting device mounting according to this invention when having a submount.

FIG. 83 is a sectional drawing showing one example of the substrate for light emitting device mounting according to this invention, obtained by joining a base and a frame.

FIG. 84 is a sectional drawing showing one example of the substrate for light emitting device mounting according to this invention which consists of a unified sintered compact which comprises an aluminum nitride as the main ingredients.

FIG. 85 is a sectional drawing showing a conventional substrate for light emitting device mounting.

FIG. 86 is a sectional drawing showing one example of the substrate for light emitting device mounting according to this invention in which a reflective prevention material and a reflective material are not formed.

FIG. 87 is a sectional drawing showing one example of the substrate for light emitting device mounting according to this invention in which a reflective prevention material is formed.

FIG. 88 is a sectional drawing showing one example of the substrate for light emitting device mounting according to this invention in which a reflective prevention material is formed.

FIG. 89 is a sectional drawing showing one example of the substrate for light emitting device mounting according to this invention in which a reflective prevention material is formed.

FIG. 90 is a sectional drawing showing one example of the substrate for light emitting device mounting according to this invention in which a reflective material is formed.

FIG. 91 is a sectional drawing showing one example of the substrate for light emitting device mounting according to this invention in which a reflective material is formed.

FIG. 92 is a sectional drawing showing one example of the substrate for light emitting device mounting according to this invention in which a reflective material is formed.

FIG. 93 is a sectional drawing showing one example of the substrate for light emitting device mounting according to this invention in which a reflective prevention material and a reflective material are formed simultaneously.

FIG. 94 is a sectional drawing showing one example of the substrate for light emitting device mounting according to this invention in which a reflective prevention material and a reflective material are formed simultaneously.

FIG. 95 is a drawing showing the optical transmissivity of the sintered compact according to this invention which comprises an aluminum nitride as the main ingredients.

FIG. 96 is a drawing showing the situation of the optical penetration by the material in which light penetrates linearly.

FIG. 97 is a drawing showing the situation of the optical penetration by the material in which the light penetrates as scattered light.

FIG. 98 is a sectional drawing showing one example of the substrate thickness of the substrate for light emitting device mounting according to this invention.

FIG. 99 is a sectional drawing showing one example of the substrate thickness of the substrate for light emitting device mounting according to this invention.

FIG. 100 is a sectional drawing showing one example of the substrate for light emitting device mounting according to this invention in which the electrical circuit was formed in the inside of a sintered compact which comprises an aluminum nitride as the main ingredients.

FIG. 101 is a sectional drawing showing one example of the substrate for light emitting device mounting according to this invention in which the electrical circuit was formed in the inside of a sintered compact which comprises an aluminum nitride as the main ingredients.

FIG. 102 is a sectional drawing showing one example of the substrate for light emitting device mounting according to this invention in which a reflective prevention material was formed in the inside of a sintered compact which comprises an aluminum nitride as the main ingredients.

FIG. 103 is a sectional drawing showing one example of the substrate for light emitting device mounting according to this invention in which a reflective material was formed in the inside of a sintered compact which comprises an aluminum nitride as the main ingredients.

### BEST MODE FOR CARRYING OUT THE INVENTION

If it sees widely, this invention relates to 1) A substrate for forming the thin film which comprises a gallium nitride, an indium nitride, and an aluminum nitride as the main ingredient(s), 2) A material of the above-mentioned substrate for thin film formation, 3) A thin film substrate in which the thin film which comprises comprises a gallium nitride, an indium nitride, and an aluminum nitride as the main ingredient(s) was formed, 4) A optical waveguide constituted by the thin film which comprises a gallium nitride, an indium nitride, and an aluminum nitride as the main ingredient(s), 5) A light emitting device constituted with the thin film which comprises a gallium nitride, an indium nitride, and an aluminum nitride as the main ingredient(s), and 6) A substrate for mounting a light emitting device.

And, this invention has the feature in the point using the various sintered compacts which comprise a ceramic material as the main ingredients as a material of a substrate, such as the sintered compact which comprises an aluminum nitride as the main ingredients.

And, if seeing more widely, this invention has two aspects.

That is, as the 1st aspect, it relates to the above 1)-5).

The invention about the above 1) -5) has been realized by finding out the phenomenon in which the thin film excellent in crystallinity which comprises as the main ingredient(s) a gallium nitride, an indium nitride, and an aluminum nitride can be formed on the various sintered compacts which comprise a ceramic material as the main ingredients, such as the sintered compact which comprises an aluminum nitride as the main ingredients, and, has been completed based on the phenomenon found out newly in process of examination which forms the thin film excellent in crystallinity which comprises as the main ingredients a gallium nitride, an indium nitride, and an aluminum nitride onto the various sintered compacts which comprise a ceramic material as the main ingredients, such as the sintered compact which comprises an aluminum nitride as the main ingredients.

On the other hand, the 2nd aspect is related to the above 6).

The thing about the above 6) is a substrate for mounting a conventional light emitting device or for mounting a light emitting device proposed newly according to this invention, and it has been completed by finding out the phenomenon in which it may emit the light from these light emitting devices efficiently to the exterior of a substrate on which the light emitting device is mounted. In order to explain this invention more plainly in the followings, the above-mentioned two aspects are indicated, respectively.

[The 1 st Aspect of this Invention]

The 1 st aspect of this invention is explained first.

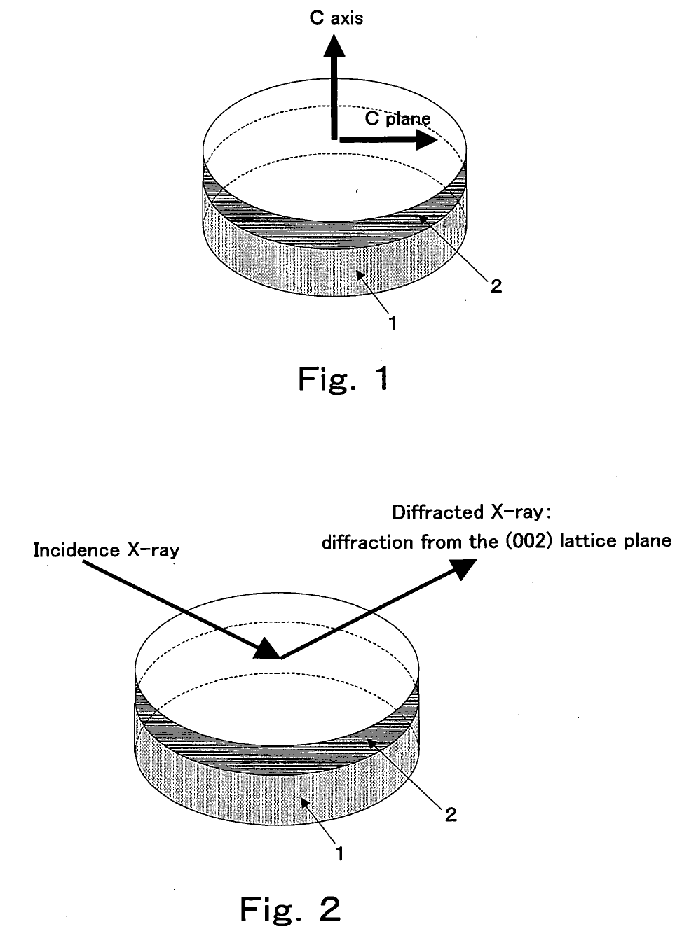

It is shown by FIG. 1-FIG. 68 as a drawing about the 1 st aspect of this invention. The contents of the mark (reference number) used in FIG. 1-FIG. 68 are as being shown below.

That is,

1: Substrate which consists of the sintered compact which comprises an aluminum nitride as the main ingredients

2: Single crystal thin film which comprises as the main ingredients at least one or more materials selected from a gallium nitride, an indium nitride, and an aluminum nitride

3: Conduction via

4: Substrate which consists of the sintered compact which comprises an aluminum nitride as the main ingredients, various sintered compacts which comprise as the main ingredients a ceramic material which has the crystal structure which can be classified as a hexagonal system, such as a silicon carbide, a silicon nitride, a zinc oxide, and a beryllium oxide etc., and can be classified as a trigonal system or a hexagonal system, such as an aluminum oxide etc., and other various sintered compacts which comprise a ceramic material as the main ingredients in addition to these

5: Thin film which comprises as the main ingredients at least one or more materials selected from a gallium nitride, an indium nitride, and an aluminum nitride

6: Thin film substrate

7: Thin film substrate which has a conduction via

8: Thin film which comprises as the main ingredients at least one or more materials selected from a gallium nitride, an indium nitride, and an aluminum nitride

9: Substrate which has a conduction via which consists of the sintered compact which comprises an aluminum nitride as the main ingredients, various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and other various sintered compacts which comprise a ceramic material as the main ingredients in addition to these

10: Substrate which consists of a sintered compact which comprises an aluminum nitride as the main ingredients and which has a conduction via

11: Thin film conductivity material

12: Thin film conductivity material with circuit pattern form

13: Substrate which consists of the sintered compact which comprises an aluminum nitride as the main ingredients

14: Substrate which consists of the sintered compact which comprises an aluminum nitride as the main ingredients

15: Thin film substrate in which thin film conductivity material was formed

16: Thin film substrate which has the conduction via in which thin film conductivity material was formed

17: Thin film substrate which has the conduction via in which thin film conductivity material was formed

18: Thin film substrate in which thin film conductivity material was formed

19: Thin film substrate in which thin film conductivity material was formed

20: Thin film substrate which has the conduction via in which thin film conductivity material was formed

21: Thin film substrate in which thin film conductivity material was formed

30: Substrate for light emitting device production

31: Buffer layer

32: Light emitting device

32-1: Thin film

32-2: Thin film which comprises as the main ingredients at least one or more materials selected from a gallium nitride, an indium nitride, and an aluminum nitride

33: Substrate for conventional light emitting device production

34: Thin film layer which has the N-type semiconductor characteristics or P type semiconductor characteristics which comprise as the main ingredients at least one or more materials selected from a gallium nitride, an indium nitride, and an aluminum nitride

34-1: Thin film layer which has the N-type semiconductor characteristics or P type semiconductor characteristics which comprise as the main ingredients at least one or more materials selected from a gallium nitride, an indium nitride, and an aluminum nitride

34-1-1: Thin film layer which has the N-type semiconductor characteristics or P type semiconductor characteristics which comprise as the main ingredients at least one or more materials selected from a gallium nitride, an indium nitride, and an aluminum nitride

34-1-2: Thin film layer which has the N-type semiconductor characteristics or P type semiconductor characteristics which comprise as the main ingredients at least one or more materials selected from a gallium nitride, an indium nitride, and an aluminum nitride

34-2: Thin film layer which has the N-type semiconductor characteristics or P type semiconductor characteristics which comprise as the main ingredients at least one or more materials selected from a gallium nitride, an indium nitride, and an aluminum nitride

34-2-1: Thin film layer which has the N-type semiconductor characteristics or P type semiconductor characteristics which comprise as the main ingredients at least one or more materials selected from a gallium nitride, an indium nitride, and an aluminum nitride

34-2-2: Thin film layer which has the N-type semiconductor characteristics or P type semiconductor characteristics which comprise as the main ingredients at least one or more materials selected from a gallium nitride, an indium nitride, and an aluminum nitride

35: Thin film layer which has the N-type semiconductor characteristics or P type semiconductor characteristics which comprise as the main ingredients at least one or more materials selected from a gallium nitride, an indium nitride, and an aluminum nitride

35-1: Thin film layer which has the N-type semiconductor characteristics or P type semiconductor characteristics which comprise as the main ingredients at least one or more materials selected from a gallium nitride, an indium nitride, and an aluminum nitride

35-1-1: Thin film layer which has the N-type semiconductor characteristics or P type semiconductor characteristics which comprise as the main ingredients at least one or more materials selected from a gallium nitride, an indium nitride, and an aluminum nitride

35-1-2: Thin film layer which has the N-type semiconductor characteristics or P type semiconductor characteristics which comprise as the main ingredients at least one or more materials selected from a gallium nitride, an indium nitride, and an aluminum nitride

35-2: Thin film layer which has the N-type semiconductor characteristics or P type semiconductor characteristics which comprise as the main ingredients at least one or more materials selected from a gallium nitride, an indium nitride, and an aluminum nitride

35-2-1: Thin film layer which has the N-type semiconductor characteristics or P type semiconductor characteristics which comprise as the main ingredients at least one or more materials selected from a gallium nitride, an indium nitride, and an aluminum nitride

35-2-2: Thin film layer which has the N-type semiconductor characteristics or P type semiconductor characteristics which comprise as the main ingredients at least one or more materials selected from a gallium nitride, an indium nitride, and an aluminum nitride

36: Luminescence layer

37: Light emitting device using a conventional substrate

38: Electrode

38-1: Terminal for electric power supplies

39: Light emitting device according to this invention

40: Dielectric material

50: Two dimension optical waveguide

60: Three dimension optical waveguide

61: Ridge type three dimension optical waveguide

62: Three dimension optical waveguide

63: Three dimension optical waveguide

64: Three dimension optical waveguide

65: Embedded type of three dimension optical waveguide

65′: Optical introductory part of an optical waveguide

66: Introductory light to an optical waveguide

66′: Emission light from an optical waveguide

70: Cladding layer

71: Cladding layer

80: Thin film which comprises as the main ingredients at least one or more materials selected from a gallium nitride, an indium nitride, and an aluminum nitride

90: Electrode

91: Electrode

100: Metallic material

110: Buffer layer

120: Electrode

130: Substrate which consists of the sintered compact which comprises as the main ingredients a ceramic material which has conductivity

140: Light emitted from the luminescence layer

141: Light which penetrated the substrate and was emitted to the light emitting device exterior

142: Light emitted to the light emitting device exterior from the thin film layer

143: Light emitted to the light emitting device exterior from the luminescence layer

150: Interface of a substrate and a thin film layer

160: Interface of a substrate and exterior space

As mentioned above, in this invention, a substrate for thin film formation also contains followings,

1) What used the sintered compact which comprises an aluminum nitride as the main ingredients as a substrate as it is,

2) What used the sintered compact which comprises as the main ingredients a ceramic material which has the crystal structure of an a hexagonal system or a trigonal system as a substrate as it is,

moreover, 3) What used the substrate in which the thin film which comprises as the main ingredients at least one or more materials selected from a gallium nitride, an indium nitride, and an aluminum nitride was formed on the substrate which consists of a sintered compact which comprises an aluminum nitride as the main ingredients,

or, 4) What used the substrate in which the thin film which comprises as the main ingredients at least one or more materials selected from a gallium nitride, an indium nitride, and an aluminum nitride was formed on the substrate which consists of a sintered compact which comprises as the main ingredients a ceramic material which has the crystal structure of a hexagonal system or a trigonal system,

in addition, 5) What used the substrate in which the thin film which comprises as the main ingredients at least one or more materials selected from a gallium nitride, an indium nitride, and an aluminum nitride was formed on the substrate which consists of a sintered compact which has optical permeability and comprises as the main ingredients a ceramic material, such as a zirconium oxide, a magnesium oxide, a magnesium aluminate, a titanium oxide, a barium titanate, a lead titanate zirconate, rare-earth oxides for example a yttrium oxide, a thorium dioxide, various ferrites, mullite, forsterite, steatite, and glass ceramics, etc.

A thin film which is formed on the above-mentioned substrate for thin film formation and which comprises as the main ingredients at least one or more materials selected from a gallium nitride, an indium nitride, and an aluminum nitride can use suitably what has at least one of the crystallized states selected from a single crystal, an amorphous state, a polycrystal, and an orientated polycrystal.

The above-mentioned thin film substrate according to this invention includes the followings, 1) The thing in which a thin film which comprises as the main ingredients at least one or more materials selected from a gallium nitride, an indium nitride, and an aluminum nitride is formed on the sintered compact which comprises an aluminum nitride as the main ingredients,

or 2) The thing in which a thin film which comprises as the main ingredients at least one or more materials selected from a gallium nitride, an indium nitride, and an aluminum nitride is formed on the sintered compact which comprises as the main ingredients a ceramic material which has the crystal structure of a hexagonal system or a trigonal system,

in addition, 3) The thing in which the thin film which comprises as the main ingredients at least one or more materials selected from a gallium nitride, an indium nitride, and an aluminum nitride was formed on the substrate which consists of a sintered compact which has optical permeability and comprises as the main ingredients a ceramic material, such as a zirconium oxide, a magnesium oxide, a magnesium aluminate, a titanium oxide, a barium titanate, a lead titanate zirconate, and rare-earth oxides for example a yttrium oxide, a thorium dioxide, various ferrites, mullite, forsterite, steatite, and glass ceramics, etc.

In addition, as for the thin film which comprises as the main ingredients at least one or more materials selected from a gallium nitride, an indium nitride, and an aluminum nitride and is formed on the substrate which consists of the above-mentioned sintered compact which comprises an aluminum nitride as the main ingredients, or the substrate which consists of a sintered compact which comprises as the main ingredients a ceramic material which has the crystal structure of an a hexagonal system or a trigonal system, or the sintered compact which has optical permeability and comprise as the main ingredients a ceramic material, such as a zirconium oxide, a magnesium oxide, a magnesium aluminate, a titanium oxide, a barium titanate, a lead titanate zirconate, and rare-earth oxides for example a yttrium oxide, a thorium dioxide, various ferrites, mullite, forsterite, steatite, and glass ceramics etc., it is characterized by comprising at least one of the crystallized states selected from a single crystal, an amorphous state, a polycrystal, and an orientated polycrystal.

The above-mentioned thin film can use not only single layer but the thin film of plural layers consisting of two or more layers.

In this invention, the above-mentioned thin film substrate can be used as a substrate for thin film formation for forming the thin film which comprises as the main ingredients at least one or more materials selected from a gallium nitride, an indium nitride, and an aluminum nitride.

According to this invention, the substrate for thin film formation and thin film substrate which are shown above can be used as a substrate for producing a light emitting device by forming on it the epitaxially grown thin film which comprises as the main ingredients at least one or more materials selected from a gallium nitride, an indium nitride, and an aluminum nitride.

Moreover, other than this, the above-mentioned thin film which grew epitaxially can be used as a substrate for a field emission material production.

The above-mentioned thin film substrate processes suitably the thin film which formed from the first on it, without further forming a thin film or a single crystal thin film, it can use for an optical waveguide and for the piezo-electric films of surface acoustic wave devices and for an insulator layer or dielectric film of wiring boards, etc.

According to this invention, the substrate for forming a single crystal thin film which comprises as the main ingredients at least one or more materials selected from a gallium nitride, an indium nitride, and an aluminum nitride is the sintered compact which comprises an aluminum nitride as the main ingredients, and is neither a bulk single crystal nor an orientated polycrystalline substance.

About a bulk single crystal, it is not the thing formed in other substrate materials etc., what is a single crystal only by itself is meant.

Therefore, if it is neither the shape of a thin film which is not related to magnitude, nor the small thing formed in other substrate materials etc. even if granular, it is a bulk single crystal.

According to this invention, because the substrate for forming a thin film which comprises as the main ingredients at least one or more materials selected from a gallium nitride, an indium nitride, and an aluminum nitride is a sintered compact, in the substrate surface, the azimuth of the aluminum nitride crystal of the main ingredient is random, and it consists of an aluminum nitride crystallite particle of all crystal orientation.

Therefore, when X-ray diffraction is performed by irradiating the characteristic X-rays of single wavelength at the above-mentioned substrate according to this invention, if it is a bulk single crystal and an orientated polycrystal, only the diffraction line from a specific crystal plane will appear, but since all diffraction lines appear except for the diffraction line which cannot appear as a basis, either by a extinction rule, the substrate according to this invention is clearly distinguishable.

The sintered compact which comprises an aluminum nitride as the main ingredients according to this invention is a polycrystalline substance which shows the above characteristics when X-ray diffraction is performed.

Such sintered compact mixes a sintering aid, an organic binder, or a solvent, etc. with the raw material powder which comprises an aluminum nitride as the main ingredients if needed, after that, it is manufactured by fabricating by methods, such as a die press, a rubber press, a slip casting, and a sheet forming, in the form according to the purpose, performing preliminary calcination of such removing of binder etc. if needed, and carrying out high temperature firing at the last, as a result, raw material powder is fired and sintered each other, and becomes dense, and the polycrystalline substance which is constituted with a fine aluminum nitride crystal grain as the main ingredients is made.

The thin film which comprises as the main ingredients at least one or more materials selected from a gallium nitride, an indium nitride, and an aluminum nitride can be formed directly on the surface of the substrate according to this invention which consists of a sintered compact which comprises an aluminum nitride as the main ingredients, and it can carry out direct formation of the single crystal which grew epitaxially at least as a thin film.

Moreover, if the substrate is a sintered compact which can form directly a single crystal thin film and which comprises an aluminum nitride as the main ingredients, the thin film of not only the above single crystal state but also the various crystallized states, such as an amorphous state, a polycrystalline state, or an orientated polycrystalline state etc., can be directly formed there as a thin film which comprises as the main ingredients at least one or more materials selected from a gallium nitride, an indium nitride, and an aluminum nitride.

In this invention, using the sintered compact which formed directly a thin film of various crystallized states, such as the above-mentioned single crystal state, an amorphous state, a polycrystalline state, and an orientated polycrystalline state, etc., and comprises an aluminum nitride as the main ingredients, when the single crystal thin film which comprises as the main ingredients at least one or more materials selected from a gallium nitride, an indium nitride, and an aluminum nitride was grown up on this substrate, the obtained single crystal thin film is easy to be formed as a single crystal thin film whose crystallinity was improved than the single crystal thin film which formed directly on the substrate which consists of a sintered compact which comprises an aluminum nitride as the main ingredients.

In this invention, the meaning “formed directly” is literally that the thin film which comprises as the main ingredients at least one or more materials selected from a gallium nitride, an indium nitride, and an aluminum nitride is formed directly on the substrate which consists of a sintered compact which comprises an aluminum nitride as the main ingredients without making other material, intermediate, etc. intervene.

In order to form the above-mentioned thin film, a special material, an intermediate, or an intervention material is not needed to the surface of the substrate which consists of a sintered compact which comprises an aluminum nitride as the main ingredients.

Thus, the single crystal thin film which is excellent in crystallinity and comprises as the main ingredients at least one or more materials selected from a gallium nitride, an indium nitride, and an aluminum nitride can be formed using the substrate according to this invention which consists of a sintered compact which comprises an aluminum nitride as the main ingredients.

The thin film formed directly on the substrate according to this invention which consists of a sintered compact which comprises an aluminum nitride as the main ingredients is able to form a single crystal substance, but it is not restricted only in that, it can form what is various crystallized states, such as an amorphous state, a polycrystalline state, or an orientated polycrystalline state.

Furthermore, when it is going to form a single crystal thin film which comprises as the main ingredients at least one or more materials selected from a gallium nitride, an indium nitride, and an aluminum nitride, a single crystal thin film with higher crystallinity is obtained by using the thin film substrate in which a thin film which comprises as the main ingredients at least one or more materials selected from a gallium nitride, an indium nitride, and an aluminum nitride and which has the above-mentioned various crystallized states was formed directly on the substrate according to this invention which consists of a sintered compact which comprises an aluminum nitride as the main ingredients.

As for the effect of the single crystal thin film substrate obtained by forming directly the thin film which comprises as the main ingredients at least one or more materials selected from a gallium nitride, an indium nitride, and an aluminum nitride and which has the various crystallized states including a single crystal or an amorphous etc. on the substrate which consists of this sintered compact which comprises an aluminum nitride as the main ingredients, and forming a single crystal thin film further, it will become still larger when this single crystal thin film substrate is used as a substrate for light emitting device production.

Although a light emitting device comprises as the main ingredients at least one or more materials selected from a gallium nitride, an indium nitride, and an aluminum nitride and is manufactured by growing epitaxially plural thin film layers, such as P type semiconductor layer, an N type semiconductor layer, and luminescence layer, and by laminating these layers, as for the characteristic of such light emitting device, the more excellent in crystallinity of an epitaxially grown thin film, which is namely a single crystal thin film, the more it excels.

Thus, in the case of manufacturing a light emitting device, when it is required that the thin film which comprises as the main ingredients at least one or more materials selected from a gallium nitride, an indium nitride, and an aluminum nitride should be formed as a single crystal thin film which has higher crystallinity, as mentioned above, it becomes more effective to use the single crystal thin film substrate according to this invention.

According to this invention, the single crystal thin film substrate includes not only the single crystal thin film substrate obtained by forming the thin film which comprises as the main ingredients at least one or more materials selected from a gallium nitride, an indium nitride, and an aluminum nitride and which has the various crystallized states, such as a single crystal, an amorphous state, a polycrystal, and an orientated polycrystal etc., directly onto the substrate which consists of the above-mentioned sintered compact which comprises an aluminum nitride as the main ingredients and by further forming a single crystal thin film, but also the single crystal thin film substrate obtained by forming the single crystal thin film which comprises as the main ingredients at least one or more materials selected from a gallium nitride, an indium nitride, and an aluminum nitride directly onto the substrate which consists of a sintered compact which comprises an aluminum nitride as the main ingredients.

As mentioned above, a thin film which comprises as the main ingredients at least one or more materials selected from a gallium nitride, an indium nitride, and an aluminum nitride and which has various crystallized states, such as a single crystal state, an amorphous state, a polycrystalline state, or an orientated polycrystalline state, can be formed directly on the substrate according to this invention which consists of a sintered compact which comprises an aluminum nitride as the main ingredients.

In this invention, it is important to form the single crystal thin film which comprises as the main ingredients at least one or more materials selected from a gallium nitride, an indium nitride, and an aluminum nitride, even if it is able to form the thin film of various crystallized states, it will not be preferred to use the substrate on which the thing of a single crystal state cannot form.

That is, the big purposes of this invention is to provide the substrate which can form the single crystal thin film which comprises as the main ingredients at least one or more materials selected from a gallium nitride, an indium nitride, and an aluminum nitride, and to provide the single crystal thin film substrate on which the single crystal thin film which comprises as the main ingredients at least one or more materials selected from a gallium nitride, an indium nitride, and an aluminum nitride was formed.

As mentioned above, a thin film which comprises as the main ingredients at least one or more materials selected from a gallium nitride, an indium nitride, and an aluminum nitride and which is a single crystal state at least can be formed directly on the substrate according to this invention which consists of a sintered compact which comprises an aluminum nitride as the main ingredients.

Thus, the substrate for single crystal thin film formation according to this invention is excellent, wherein the thin film which comprises as the main ingredients at least one or more materials selected from a gallium nitride, an indium nitride, and an aluminum nitride and is a single crystal state can directly form.

However, in the actual use form in which the substrate for single crystal thin film formation according to this invention is used, it is not necessarily limited only to the above-mentioned substrate for forming a single crystal thin film which comprises as the main ingredients at least one or more materials selected from a gallium nitride, an indium nitride, and an aluminum nitride.

Tthe thin film which is various crystallized states, such as an amorphous state, a polycrystalline state, and an orientated polycrystalline state, and which comprises as the main ingredients at least one or more materials selected from a gallium nitride, an indium nitride, and an aluminum nitride can also be formed directly on the substrate for single crystal thin film formation according to this invention which consists of a sintered compact which comprises an aluminum nitride as the main ingredients.

The substrate for single crystal thin film formation according to this invention which consists of a sintered compact which comprises an aluminum nitride as the main ingredients can use as a substrate actually not only for forming the thin film of single crystal state which comprises as the main ingredients at least one or more materials selected from a gallium nitride, an indium nitride, and an aluminum nitride but also for forming the thin film which is various crystallized states, such as an amorphous state, a polycrystal, and an orientated polycrystal, and which comprises as the main ingredients at least one or more materials selected from a gallium nitride, an indium nitride, and an aluminum nitride.

As mentioned above, as for the sintered compact according to this invention which can form the single crystal thin film and which comprises an aluminum nitride as the main ingredients, it is able to form not only a single crystal thin film but also a thin film which is various crystallized states, such as an amorphous state, a polycrystal, and an orientated polycrystal, and which comprises as the main ingredients at least one or more materials selected from a gallium nitride, an indium nitride, and an aluminum nitride.

When saying concretely, this invention can supply the thin film substrates in which the thin film of various crystallized states, such as amorphous thin films, polycrystalline thin films, or orientated polycrystalline thin films other than the single crystal thin film which was formed on the substrate which consists of a sintered compact which comprises an aluminum nitride as the main ingredients, was formed, for example, 1) the thing in which a single crystal thin film which comprises as the main ingredients at least one or more materials selected from a gallium nitride, an indium nitride, and an aluminum nitride was formed on the substrate which consists of a sintered compact which comprises an aluminum nitride as the main ingredients, 2) the thing in which an amorphous thin film which comprises as the main ingredients at least one or more materials selected from a gallium nitride, an indium nitride, and an aluminum nitride was formed on the substrate which consists of a sintered compact which comprises an aluminum nitride as the main ingredients, 3) the thing in which a polycrystalline thin film which comprises as the main ingredients at least one or more materials selected from a gallium nitride, an indium nitride, and an aluminum nitride was formed on the substrate which consists of a sintered compact which comprises an aluminum nitride as the main ingredients, 4) the thing in which an orientated polycrystalline thin film which comprises as the main ingredients at least one or more materials selected from a gallium nitride, an indium nitride, and an aluminum nitride was formed on the substrate which consists of a sintered compact which comprises an aluminum nitride as the main ingredients, etc.

That is, this invention is a substrate for forming a thin film which comprises as the main ingredients at least one or more materials selected from a gallium nitride, an indium nitride, and an aluminum nitride, and the substrate contains a substrate for thin film formation which consists of a sintered compact which comprises an aluminum nitride as the main ingredients.

Furthermore, this invention also includes the thin film substrate, wherein the thin film which comprises as the main ingredients at least one or more materials selected from a gallium nitride, an indium nitride, and an aluminum nitride is being formed on the substrate which consists of a sintered compact which comprises an aluminum nitride as the main ingredients.

The sintered compact which comprises an aluminum nitride as the main ingredients according to this invention can use equally to both uses, for the substrate for single crystal thin film formation, and for the substrate for thin film formation.

In this invention, when forming the thin film which comprises as the main ingredients at least one or more materials selected from a gallium nitride, an indium nitride, and an aluminum nitride and is various crystallized states, such as a single crystal, an amorphous state, a polycrystal, and an orientated polycrystal etc., special film formation technique is not needed, an usual MOCVD (Metal Organic Chemical Vapor Deposition) method, an MOVPE (Metal Organic Vapor Phase Epitaxy) method, a Hydride VPE (Hydride Vapor Phase Epitaxy) method, a Halide VPE (Halogen Transport Vapor Phase Epitaxy) method containing a Chloride VPE (Chloride Vapor Phase Epitaxy) method, etc., a Plasma CVD method, other CVD (Chemical Vapor Deposition) method, and an MBE (Molecular Beam Epitaxy) method, or a laser ablation method using the Excimer laser etc. and using as a raw material the solid material containing the purpose ingredient which was formed beforehand, a PLD method (Pulse Laser Deposition: Pulse Laser Deposition), a Sputtering method, an Ion-plating method, or a Vacuum deposition etc., anything is arbitrarily applicable if it is the method of growing up the thin film of the target composition, that is, decomposing or not decomposing chemically physically the compound and simple substance containing at least a part of target chemical component, then making it into gas, ion, or a molecular beam in the state as it is, it is made to react or not to react with the compound except above-mentioned suitably, after making the ingredient containing the target chemical component into the gaseous phase.

As the raw material for thin film production of various crystallized states, such as a single crystal state, an amorphous state, a polycrystalline state, and an orientated polycrystalline state, organic metallic compounds, such as Trimethyl gallium, Triethyl gallium, Tri-iso-butyl gallium, Trimethyl indium, Triethyl indium, Tri-iso-butyl indium, Trimethyl aluminum, Triethyl aluminum, and Tri-iso-butyl aluminum, the halogenated compounds of gallium, indium, and aluminum, such as chlorides such as a gallium chloride, an indium chloride, and an aluminium chloride, and bromides such as a gallium bromide, an indium bromide, and an aluminum bromide, the organic compounds of gallium, indium, and aluminum which contains halogens such as Diethyl gallium chloride, Diethyl indium chloride, Diethyl aluminum chloride, nitrides, such as a gallium nitride, an indium nitride, and an aluminum nitride, pure metals, such as gallium, indium, and aluminum, in addition, it is as an object for doping elements, Si, or silane compounds, such as SiH₄, SiHCl₃, and Si (C₂H₅)₄, the halogenated compound of silicon, such as SiCl₄ and SiBr₄, Silicon compounds, such as Si₃N₄ and SiC, metals, such as magnesium, beryllium, calcium, zinc, cadmium, and germanium, and compounds, such as halogenated compounds and the organic metallic compounds containing these metals, such as dialkyl beryllium (for example, dimethyl beryllium etc.), dialkylmagnesiums (for example, dimethyl magnesium etc.) and Bis-cyclopentadienyl magnesium (MgCp₂), Bis-cyclopentadienyl calcium (CaCp₂), Diethyl zinc, Dimethyl cadmium, Tetramethyl germanium, BeCl₂, BeBr₂, MgCl₂, MgBr₂, CaCl₂, CaBr₂, ZnCl₂, ZnBr₂, CdCl₂, CdBr₂, GeCl₄, GeBr₄, or the compound containing a nonmetal and these nonmetals, such as carbon, silicon, selenium, tellurium, and oxygen, etc., various compounds can be used.

In an MOCVD method and an MOPVE method, organic compounds, such as Trimethyl gallium, Trimethyl indium, and Trimethyl aluminum, are used as a main raw material.

In Chloride VPE and a Halide VPE method, halogenated compounds, such as a gallium chloride, an indium chloride, and aluminium chloride, are used as a main raw material.

in the methods of forming a thin film by making a raw material into a gaseous state, such as the above-mentioned MOCVD method, an MOPVE method, a Hydrides VPE method, a Chloride VPE method, a Halide VPE method, a Plasma CVD method, other CVD methods, and an MBE method, ammonia or nitrogen is usually used alone or in the mixed state as gas for reacting with a raw material.

Hydrogen, argon, or nitrogen are used alone or in the mixed state as carrier gas which makes a raw material a gaseous state and conveys it into the reaction area.

As an ambient atmosphere in a thin film formation chamber, ammonia, hydrogen, argon, nitrogen, etc. are usually used under ordinary pressure or under decompression.

When forming a thin film by a Sputtering method, what formed as a target the various above-mentioned raw materials is used.

By such method, the thin film which comprises as the main ingredients at least one or more materials selected from a gallium nitride, an indium nitride, and an aluminum nitride can be arbitrarily obtained in various crystallized states, such as a single crystal, an amorphous state, a polycrystal, and an orientated polycrystal.

It is usually desirable to carry out at 400 degrees C.-1200 degrees C. when forming the thin film which comprises a gallium nitride as the main ingredients, 400 degrees C.-1000 degrees C. when forming the thin film which comprises an indium nitride as the main ingredients, 500 degrees C.-1500 degrees when forming the thin film which comprises an aluminum nitride as the main ingredients, as for the substrate temperature in the case of forming the thin film which comprises as the main ingredients at least one or more materials selected from the above-mentioned gallium nitride, the indium nitride, and the aluminum nitride.

In each above-mentioned thin film, when forming the thin film which comprises a gallium nitride as the main ingredients and which has crystallized states other than single crystals, such as an amorphous state, a polycrystal, and an orientated polycrystal, 400 degrees C.-900 degrees C. are desirable as substrate temperature, and in the case of forming a single crystal thin film, it is desirable to carry out by raising 700 degrees C.-1200 degrees C. as substrate temperature.

When forming the thin film which comprises an indium nitride as the main ingredients and which has crystallized states other than single crystals, such as an amorphous state, a polycrystal, and an orientated polycrystal, 400 degrees C.-700 degrees C. are desirable as substrate temperature, and in the case of forming a single crystal thin film, it is desirable to carry out by raising 500 degrees C.-900 degrees C. as substrate temperature.

When forming the thin film which comprises an aluminum nitride as the main ingredients and which has crystallized states other than single crystals, such as an amorphous , a polycrystal, and an orientated polycrystal, 500 degrees C.-1200 degrees C. are desirable as substrate temperature, and in the case of forming a single crystal thin film, it is desirable to carry out by raising 600 degrees C.-1500 degrees C. as substrate temperature.

In the case of more specifically forming a single crystal thin film by an MOCVD method and an MOPVE method, as substrate temperature, 900 degrees C.-1100 degrees C. are preferable when forming the thin film which comprises a gallium nitride as the main ingredients, 600 degrees C.-900 degrees C. are preferable when forming the thin film which comprises an indium nitride as the main ingredients, 900 degrees C.-1200 degrees C. are preferable when forming the thin film which comprises an aluminum nitride as the main ingredients.

In the case of forming a single crystal thin film by a Chloride VPE method or a Halide VPE method, 900 degrees C.-1250 degrees C. are preferable as substrate temperature, when forming the thin film which comprises a gallium nitride(GaN) as the main ingredients, 700 degrees C.-1000 degrees C. are preferable when forming the thin film which comprises an indium nitride(InN) as the main ingredients, 1000 degrees C.-1500 degrees C. are preferable when forming the thin film which comprises an aluminum nitride(AlN) the main ingredients.

The resistance heating which used various heaters, the high frequency heating using an RF generator, heating by an infrared lamp, etc. can use heating of a substrate by any methods.

Even if it uses what kind of thin film forming method in this invention, as substrate temperature, it is not limited only to the above range. It can form at cold temperature comparatively, namely, room temperature -400 degrees C. are preferable as substrate temperature when forming the thin film which comprises a gallium nitride as the main ingredients, room temperature −400 degrees C are preferable as substrate temperature when forming the thin film which comprises an indium nitride as the main ingredients, room temperature −500 degrees C. are preferable when forming the thin film which comprises an aluminum nitride as the main ingredients.

Using methods, such as a Sputtering method, an Ion-plating method, and Vacuum deposition, as an example of such method, a thin film can be formed comparatively at low temperature as mentioned above.

Moreover, for example, also in the method of forming a thin film with the raw material of a gaseous state and reactive gas, for example, if the reactive gas, such as ammonia or nitrogen, has plasma state by high frequency (for example, microwave with a frequency of 2.45 GHz or a radio wave with a frequency of 13.56 MHz etc.), magnetism, etc., even if substrate temperature will be cold temperature as mentioned above, a good thin film can be obtained.

As for the single crystal thin film which comprises as the main ingredients at least one or more materials selected from a gallium nitride, an indium nitride, and an aluminum nitride which grow on the substrate which consists of a sintered compact which comprises an aluminum nitride as the main ingredients, the crystal system is expressed with a hexagonal system (Hexagonal) in this invention.

The single crystal thin film formed when the above-mentioned CVD method etc. is used has the orientation which is usually easy to grow epitaxially in the C axis azimuth of this hexagonal to a substrate surface.

In other words, the above-mentioned single crystal thin film has the orientation which is easy to grow epitaxially in the azimuth where the C plane is parallel to a substrate surface.

Since the strong diffraction line from the lattice plane of the Miller Index (002) of hexagonal system will be observed if this performs X-ray diffraction of the above-mentioned single crystal thin film formed on the substrate, growing epitaxially in the direction of C axis to a substrate surface can explain the above-mentioned single crystal thin film from being observed.

In other words, that the substrate surface and the C plane are growing epitaxially in parallel can explain the above-mentioned single crystal thin film from being observed.

This situation is shown in FIG. 1.

The single crystal thin film 2 which comprises as the main ingredients at least one or more materials selected from a gallium nitride, an indium nitride, and an aluminum nitride is being formed on the substrate 1 which consists of the sintered compact which comprises an aluminum nitride as the main ingredients in FIG. 1.

When using the substrate on which the single crystal thin film 2 is formed in the direction where C axis is perpendicular to the substrate surface as shown in FIG. 1, if X-ray irradiates the surface of this single crystal thin film 2, only the diffraction line from the lattice plane of the Miller Index (002) of an aluminum nitride crystal which has a hexagonal wurtzite type crystal structure will be obtained.

This situation is shown in FIG. 2.

Since plural diffraction lines, such as diffraction from lattice planes (100) other than the lattice plane of the Miller Index (002) of hexagonal system as shown in FIG. 2, will be observed if the thin film formed on the substrate 1 is in not a single crystal but the polycrystallized condition, it is clearly distinguishable.

An orientated polycrystal is a polycrystalline substance of the special state in which the crystal grain gathered in the direction of a specific crystallographic axis.

Even if it is such orientated polycrystal, it can distinguish from a single crystal comparatively easily.

If it says more concretely, the thin film which comprises as the main ingredients at least one or more materials selected from a gallium nitride, an indium nitride, and an aluminum nitride has a wurtzite type crystal structure, for example, if the single crystal thin film formed in the direction where C axis is perpendicular to the substrate surface performs the usual X-ray diffraction 2θ/θ scan, only the diffraction line from the lattice plane of a Miller Index (002) will appear. Also in the orientated polycrystal formed in the direction where C axis of a thin film is perpendicular to a substrate surface on the other hand, with 2θ/θ scan of X-ray diffraction, only the diffraction line from the lattice plane of a Miller Index (002) appears. However, it is although only the diffraction line from the lattice plane of a Miller Index (100) will appear if the lattice plane of a Miller Index (100) parallel to C axis is fixed in the case of a single crystal thin film and 2θ/φ scan is performed, since the diffraction line from other lattice planes, for example, Miller Index (110) lattice plane, parallel to C axis also appears in the case of an orientated polycrystalline thin film, the formed thin film can judge easily that difference which is a single crystal or an orientated polycrystal.

That is, while a rotation in a C plane is not seen in the case of the single crystal, a rotation of a crystal is looked in a C plane in the case of an orientated polycrystalline thin film.

While it is homogeneous and is combined and there is no boundary as a crystal grain in the case of a single crystal, it is a crystal grain's aggregate in the case of an orientated polycrystal, though the crystallographic axis (for example, C axis) is assembled in the specific direction in each crystal grain, other crystallographic axes (for example, A-axis) are considered because a different azimuth in each crystal grain is taken.

Thus, an orientated polycrystal can also be called a polycrystalline substance of the special state where the crystal grain gathered in the direction of a specific crystal axis.

As mentioned above, in the case of a usual polycrystalline thin film if an X-ray diffraction 2θ/θ scan is performed, the diffraction line appears not only from the lattice plane of a Miller Index (002) but also from the lattice plane of (100) for example , so it can distinguish the usual polycrystalline thin film from a usual orientated polycrystalline thin film easily.

If the thin film which is formed on the substrate 1 is not a single crystal or polycrystal but an amorphous state, a diffraction line with a clear peak is not obtained so a diffraction line serves as a broad pattern, so it is clearly distinguishable from a single crystal, a polycrystal, or an orientated polycrystal.

In FIG. 1, this single crystal thin film 2 tends to grow in the direction of C axis, the growth direction is a perpendicular direction to a substrate surface, that is, a level direction to the substrate surface is the direction of a C plane of this single crystal thin film 2.

In this invention. C axis of the single crystal thin film which comprises as the main ingredients at least one or more materials selected from a gallium nitride, an indium nitride, and an aluminum nitride and is formed on the substrate which consists of a sintered compact which comprises an aluminum nitride as the main ingredients tends to grow in the perpendicular direction spontaneously to a substrate surface.

However, if the growth method of a thin film is suitably devised even when the substrate which consists of the above-mentioned sintered compact which comprises an aluminum nitride as the main ingredients is used, C axis of the single crystal thin film which comprises as the main ingredients at least one or more materials selected from a gallium nitride, an indium nitride, and an aluminum nitride can be formed in the level direction to a substrate surface.

For example, if it devises supplying the source gas for thin film formation from a level direction to a substrate, setting up the above-mentioned substrate temperature lowness at first, and raising temperature gradually, C axis of the single crystal thin film which comprises as the main ingredients at least one or more materials selected from a gallium nitride, an indium nitride, and an aluminum nitride can be formed in the level direction to a substrate surface.

This situation is shown in a FIG. 4.

FIG. 4 shows the thing in which C axis of the single crystal thin film 2 which comprises as the main ingredients at least one or more materials selected from a gallium nitride, an indium nitride, and an aluminum nitride and is formed on the substrate 1 which consists of the sintered compact which comprises an aluminum nitride as the main ingredients is formed in the level direction to the substrate surface (namely, the C plane is formed in the perpendicular direction to the substrate surface).

In this invention, especially crystalline evaluation of the single crystal thin film which comprises as the main ingredients at least one or more materials selected from a gallium nitride, an indium nitride, and an aluminum nitride by an X-ray rocking curve was performed using what grew in the direction where C axis is perpendicular to the substrate surface as shown in FIG. 1, unless it refused.

When performing surface X-ray diffraction only by the substrate 1 which consists of the sintered compact which comprises an aluminum nitride as the main ingredients, the diffraction line which is equivalent to AlN powder which is described at the JCPDS (Joint Committee on Powde Diffraction Standards) file number 25-1134 is obtained, and the aluminum nitride particle in a sintered compact shows that it is the polycrystalline state which has turned to specific not a direction but all directions.

Although the form of the substrate illustrated in FIG. 1, FIG. 2, and a FIG. 4 is circular, the form of the substrate which can be used in this invention can use the thing of arbitrary form, such as not only a round shape but a square, a rectangle, or other polygons.

As for the thin film substrate produced using the sintered compact which comprises an aluminum nitride as the main ingredients and the substrate for thin film formation according to this invention which consists of the sintered compact which comprises an aluminum nitride as the main ingredients, as illustrated in FIG. 1, FIG. 2, and the FIG. 4, what has arbitrary magnitude can be produced using the method which is usually used in a sintered compact production and thin film production.

That is, in the cases of a sintered compact, for example, a thing with a contour of about 0.01 mm-1000 mm and a thickness of about 1 μm-20 mm is easily producible.

In this invention, the thin film which was formed on the sintered compact comprising an aluminum nitride as the main ingredients and which comprises as the main ingredients at least one or more materials selected from a gallium nitride, an indium nitride, and an aluminum nitride and has various crystallized states, such as a single crystal, an amorphous state, a polycrystal, and an orientated polycrystal etc. and the sintered compact which comprises an aluminum nitride as the main ingredients are joined firmly, the crack in the formed thin film and the exfoliation at the junction interface etc. are not seen between this thin film and the sintered compact which comprises an aluminum nitride as the main ingredients.

About junction nature, even if it tests by pasting up and tearing off pressure sensitive adhesive tape to the formed above-mentioned thin film, the exfoliation or the breakdown in a junction interface of this thin film and a sintered compact which use this thin film and an aluminum nitride as the main ingredients are not seen.

The junction nature between the sintered compacts which comprise an aluminum nitride as the main ingredients and the thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal etc., is usually not less than 2 Kg/mm² by perpendicular tension strength, and the thing of not less than 4 Kg/mm² by perpendicular tension strength is also obtained further.

In the single crystal thin film which comprises as the main ingredients a gallium nitride and an indium nitride among the single crystal thin films which comprise as the main ingredients at least one or more materials selected from a gallium nitride, an indium nitride, and an aluminum nitride, when the crystallinity of the thin film of the single crystal state contained is judged according to X-ray diffraction as mentioned above, since the diffraction line from the lattice plane of the Miller Index (002) of the single crystal thin film which has a hexagonal wurtzite type crystal structure, and the diffraction line from the lattice plane of the Miller Index (002) of hexagonal system of the base substrate which consists of a sintered compact which comprises an aluminum nitride as the main ingredients are distinguishable clearly, X-ray diffractometry can use for a crystallinity judgment of the thing with almost all the thickness of the single crystal thin film formed.

Since lattice constants differ little by little even if a gallium nitride, an indium nitride, and an aluminum nitride has a wurtzite type crystal structure belonging to a same hexagonal system, it is because the locations of the diffraction line from the lattice plane of the Miller Index (002) of hexagonal system by X-ray diffraction differ in the degree which can be distinguished easily.

When CuKα rays (wavelength 1.542 A) are used as a characteristic X-rays, the diffraction line from the lattice plane of the Miller Index (002) of the substrate made from an aluminum nitride sintered compact appears in the range θ=17.65 degrees-18.45 degrees of angles of diffraction, the diffraction line from the lattice plane of the Miller Index (002) of a gallium nitride single crystal thin film appears in the range of θ=17.20 degrees-17.53 degrees of angles of diffraction, the diffraction line from the lattice plane of the Miller Index (002) of an indium nitride single crystal thin film appears in the range of near θ=15.55 degrees -15.88 degrees of angles of diffraction, so an overlap which makes judgment of these diffraction lines impossible does not arise substantially.

On the other hand, the diffraction line from the lattice plane of the Miller Index (002) of the single crystal thin film which comprises an aluminum nitride as the main ingredients is in the range of θ=17.88 degrees-18.20 degrees of angles of diffraction.

Therefore, when the crystallinity of the single crystal thin film which comprises an aluminum nitride as the main ingredients among the above-mentioned single crystal thin films is judged according to X-ray diffraction, if the thickness of this single crystal thin film which is being formed becomes thin, an X-ray penetrates this single crystal thin film, so the diffraction line from the base sintered compact which comprises an aluminum nitride as the main ingredients will be overlapped, the influence come to be seen.

The characteristic X-rays which used in this invention used the CrKα rays (wavelength 2.291 A) of comparatively long wavelength, or CuKα, in order to control transmission energy small, and it handled by applying acceleration voltage as small as possible to an X-ray tube.

When the crystallinity of the single crystal thin film which comprises an aluminum nitride as the main ingredients is judged according to X-ray diffraction, the limit thickness of the single crystal thin film which can eliminate the effect of the diffraction from the base sintered compact which comprises an aluminum nitride as the main ingredients is about 500 nm by the above devices.

For the judgment of the single crystal nature of the thin film which comprises an aluminum nitride as the main ingredients and has the thickness up to not more than 500 nm from about 5 nm, electron diffraction, such as RHEED (Reflection High Energy Electron Diffraction), was used together, and it was considered to it that there was no effect from the sintered compact which comprises an aluminum nitride as the main ingredients and is a substrate.

Therefore, in this invention, crystallinity evaluation by the half width of the rocking curve of the X-ray diffraction line from the lattice plane of the Miller Index (002) of the single crystal thin film which comprises an aluminum nitride as the main ingredients and forms on the substrate which consists of a sintered compact which comprises an aluminum nitride as the main ingredients was usually performed by this single crystal thin film with the thickness not less than 500 nm, or preferably not less than 1000 nm.

As for the thin film which comprises as the main ingredients at least one or more materials selected from a gallium nitride, an indium nitride, and an aluminum nitride and which was formed according to this invention, what is the thickness of about 0.5 nm can be formed, even if a thickness is about such at least 0.5 nm, it is thought that it is formed as a single crystal.

In this invention, the above-mentioned thin film can form not only a single crystal but the thing of various crystallized states, such as an amorphous state, a polycrystal, and an orientated polycrystal.

In these thin films, the thickness can also form a thing with a thickness of about 0.1 nm-0.2 nm.

When the above-mentioned thin film is directly formed in this substrate, using the sintered compact which comprises an aluminum nitride as the main ingredients as a substrate for thin film formation, as for the thickness of a thin film, it is preferred that it is not less than 0.5 nm.

In this invention, the thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal etc., can be formed using the substrate for thin film formation which consists of various sintered compacts which comprise as the main ingredients a ceramic material, such as an aluminum nitride.

The single crystal thin film substrate in which the single crystal thin film which comprises as the main ingredients at least one or more materials selected from a gallium nitride, an indium nitride, and an aluminum nitride was formed directly to the above-mentioned substrate for thin film formation, and, the single crystal thin film substrate which formed furthermore the single crystal thin film which comprises as the main ingredients at least one or more materials selected from a gallium nitride, an indium nitride, and an aluminum nitride on the thin film substrate in which the thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal etc., was formed can be obtained.

Furthermore, the thin film which comprises as the main ingredients at least one or more materials selected from a gallium nitride, an indium nitride, and an aluminum nitride and which is various crystallized states, such as a single crystal used, an amorphous state, a polycrystal, and an orientated polycrystal etc., can be formed on the above-mentioned thin film substrate.

In this invention, the thin film of various crystallized states, such as an amorphous state, a polycrystal, and an orientated polycrystal, can also usually be formed comparatively easily in the substrate in which a single crystal among the above-mentioned thin films can be formed.

In this invention, it was judged by evaluating the crystallinity of the single crystal which was formed in this substrate whether the above-mentioned substrate for thin film formation and the thin film substrate would be excellent.

In this invention, as mentioned above, the crystallized state of the thin film which comprises as the main ingredients at least one or more materials selected from a gallium nitride, an indium nitride, and an aluminum nitride can be easily judged by analysis according to X-ray diffraction.

That is, if the above-mentioned thin film is a single crystal, when C axis of this single crystal thin film is formed in the perpendicular azimuth to the substrate surface, only the diffraction line from the lattice plane of the Miller Index (002) of a hexagonal wurtzite type crystal is detected.

When C axis of this single crystal thin film is formed in the level azimuth to the substrate surface, only the diffraction line from the lattice plane of the Miller Index (100) of a hexagonal wurtzite type crystal is detected.

if the above-mentioned thin film is polycrystal, since plural diffraction lines such as a Miller Index (002), or (100), etc., from a lattice plane are detected, it can distinguish easily.

If the above-mentioned thin film is amorphous, since a clear diffraction peak is not detected but serves as a broad diffraction pattern, it can be distinguished easily.

When the sintered compact which comprises an aluminum nitride as the main ingredients according to this invention is used as a substrate for thin film formation, as for the single crystal thin film which comprises as the main ingredients at least one or more materials selected from a gallium nitride, an indium nitride, and an aluminum nitride, C axis is easy to be formed in a perpendicular azimuth to a substrate surface, so only the diffraction line from the lattice plane of the Miller Index (002) of a hexagonal wurtzite type crystal is usually detected.

Unless especially crystalline evaluation of this single crystal thin film usually made reference in this invention, it carried out by measuring the half width of the rocking curve of the X-ray diffraction line from the lattice plane of the Miller Index (002) of this single crystal thin film.

The used characteristics X-rays are CuK alpha rays (wavelength 1.542 A).

Unless reference is made especially in this invention, the half width of the rocking curve of the X-ray diffraction line from the lattice plane of a Miller Index (002) is measured by the usual ω scan, and a second(arcsecant) shows it as an unit.

In performing the crystallinity evaluation, as the surface of a substrate which consists of various sintered compacts which comprise as the main ingredients a ceramic material, such as an aluminum nitride, and which is used as a substrate for the single crystal thin film formation, the thing which was made into the state of a specular plane and has average surface roughness Ra=30 nm can be used, unless reference is made especially.

The substrate for thin film formation according to this invention should just be the sintered compact which comprises an aluminum nitride as the main ingredients, the thin film which is the various crystallized states containing the single crystal and comprises as the main ingredients at least one or more materials selected from a gallium nitride, an indium nitride, and an aluminum nitride can be formed directly on the substrate.

Using what has optical permeability in the above-mentioned sintered compact which comprises an aluminum nitride as the main ingredients, it tends to raise the crystallinity of the single crystal thin film which comprises as the main ingredients at least one or more materials selected from a gallium nitride, an indium nitride, and an aluminum nitride and is formed on a substrate.

In such sintered compact, if optical permeability at least in a visible light area is high, since the crystallinity of the formed single crystal thin film which comprises as the main ingredients at least one or more materials selected from a gallium nitride, an indium nitride, and an aluminum nitride will increase, it is desirable.

As for the optical permeability in a visible light area of the range of 380 nm-800 nm wavelength, it is preferred that the optical transmissivity is not less than 1% in the sintered compact which has a disc-like shape of 25.4 mm diameter and 0.5 mm thickness and has been polished to a mirror plane of average surface roughness about Ra=30 nm.

If the substrate which consists of a sintered compact which comprises an aluminum nitride as the main ingredients and whose optical transmissivity is not less than 1% is used, as for the crystallinity of the single crystal thin film which was directly formed on it and comprises as the main ingredients at least one or more materials selected from a gallium nitride, an indium nitride, and an aluminum nitride, a good thing, such that the half width of the rocking curve of the X-ray diffraction line from the lattice plane of a Miller Index (002) is not more than 300 seconds, is easy to obtain.

Using the substrate which consists of a sintered compact which comprises an aluminum nitride as the main ingredients and whose optical transmissivity is not less than 5%, a better thing, such that the half width of the above-mentioned rocking curve of the X-ray diffraction is not more than 240 seconds, is easy to be obtained.

Furthermore, using the substrate which consists of a sintered compact which comprises an aluminum nitride as the main ingredients and whose optical transmissivity is not less than 10%, a still better thing, such that the half width of the above-mentioned rocking curve of the X-ray diffraction is not more than 200 seconds, is easy to be obtained, it is more desirable.

In this invention, the optical transmissivity in a visible light area is the optical transmissivity in the light of the range of the above-mentioned 380 nm-800 nm wavelength, and unless reference is made especially in this invention, the value of the optical transmissivity measured by the light of 605 nm wavelength was used.

According to this invention, the sintered compact which comprises an aluminum nitride as the main ingredients and has the optical transmissivity in the above visible light has also the same optical transmissivity in the light of an ultraviolet region of a 200 nm-380 nm wavelength, what is not less than 1% as the optical transmissivity is obtained.

That is, in this invention, in such sintered compact which comprises an aluminum nitride as the main ingredients, if the optical permeability to the light of the range of at least 200 nm-800 nm wavelength is high, since the crystallinity of the formed single crystal thin film which comprises as the main ingredients at least one or more materials selected from a gallium nitride, an indium nitride, and an aluminum nitride will increase, it is desirable.

Moreover, in the sintered compact according to this invention which comprises an aluminum nitride as the main ingredients and has the visible optical transmissivity, what has the optical transmissivity not less than 5% in the ultraviolet light of the range of 250-380 nm wavelength is obtained, what has the optical transmissivity not less than 10% in the ultraviolet light of the range of 300-380 nm wavelength is obtained.

In the sintered compact which comprises an aluminum nitride as the main ingredients according to this invention, what has the optical transmissivity not less than 40% is obtained in the ultraviolet light of the above range of 200-380 nm wavelength, and what has a maximum of 60-80%, or what has the optical transmissivity not less than 80% are also obtained furthermore.

As mentioned above, the substrate by this invention which consists of a sintered compact which comprises an aluminum nitride as the main ingredients also has optical permeability to ultraviolet light, if the device for emitting ultraviolet-rays is formed by using, for example, the single crystal thin film which comprises as the main ingredients at least one or more materials selected from a gallium nitride, an indium nitride, and an aluminum nitride to the above-mentioned substrate according to this invention, it is rare to absorb the ultraviolet rays which emitted light from the device in a substrate portion, so the effect that the luminous efficiency of a light emitting device increases is acquired, and it is desirable.

Thus, in this invention, the substrate which consists of a sintered compact which comprises an aluminum nitride as the main ingredients has the optical transmissivity at least not less than 1% in the light of the range of 200 nm-800 nm, it was shown clearly that the single crystal thin film which comprises as the main ingredients at least one or more materials selected from a gallium nitride, an indium nitride, and an aluminum nitride which have the crystallinity which was more excellent by using the substrate which has such transmissivity could be formed.

In this invention, by using the substrate which consists of a sintered compact which comprises an aluminum nitride as the main ingredients and has the optical transmissivity not less than 1%, the thin film which comprises as the main ingredients at least one or more materials selected from a gallium nitride, an indium nitride, and an aluminum nitride and is the various crystallized states, such as an amorphous state, a polycrystal, and an orientated polycrystal, other than the single crystal, can also be formed.

Unless reference is made especially in this invention, followings, optical transmissivity is measured by the light with a wavelength 605 nm.

According to this invention, the sintered compact which comprises an aluminum nitride as the main ingredients and which has optical permeability shows usually the almost same transmissivity as transmissivity measured by the light with a wavelength 605 nm to the light of any wavelength at least in the visible light area of the range of a wavelength of 380 nm-800 nm.

Although the sintered compact which comprises an aluminum nitride as the main ingredients according to this invention does not necessarily have the same transmissivity as the 605 nm wavelength in the light of all the wavelength ranges of 200 nm-800 nm wavelength except the wavelength 605 nm, only using the transmissivity measured by the light with a wavelength 605 nm it can distinguish on behalf of the performances of the sintered compact which comprises an aluminum nitride as the main ingredients according to this invention, for example, the crystallinity when forming the single crystal thin film which comprises as the main ingredients at least one or more materials selected from a gallium nitride, an indium nitride, and an aluminum.

That is, the characteristics as a substrate of the sintered compact which comprises an aluminum nitride as the main ingredients and which has optical permeability can be represented and judged by the optical transmissivity measured by the light of an above-mentioned wavelength 605 rim.

In this invention, the sintered compact which comprises an aluminum nitride as the main ingredients and which has optical permeability usually shows optical permeability to the light with a wavelength not less than 200 nm in many cases.

That is, optical permeability begins to be shown to the light of the range of 200 nm-250 nm wavelength, an optical permeability goes up rapidly to the light of the range of 250 nm-350 nm wavelength, and there is tendency of having almost fixed optical transmissivity to the light with a wavelength not less than 350 nm-400 nm which is in the boundary area which goes into a visible light area from ultraviolet light.

Unless reference is made especially in this invention, the optical transmissivity of a sintered compact which comprises an aluminum nitride as the main ingredients means the optical transmissivity measured by the light with wavelength 605 nm.

Usually, in this invention, the optical transmissivity of the visible light in the range of 380 nm-800 nm wavelength is larger than the optical transmissivity measured by ultraviolet light with 200 nm-380 run wavelength in the sintered compact which comprises an aluminum nitride as the main ingredients and which has optical permeability.

Concretely, usually, in this invention, if the optical transmissivity measured by ultraviolet light with 200 nm-380 nm wavelength is not less than 1% in the sintered compact which comprises an aluminum nitride as the main ingredients and which has optical permeability, the optical transmissivity in the visible light of the range of 380 nm-800 nm wavelength will become bigger than 1%.

Therefore, when the sintered compact which comprises an aluminum nitride as the main ingredients and has optical permeability and whose optical transmissivity measured by ultraviolet light with 200 nm-380 nm wavelength is not less than 1% is used as a substrate, the single crystal thin film which has the more excellent crystallinity and which comprises as the main ingredients at least one or more materials selected from a gallium nitride, an indium nitride, and an aluminum nitride can be formed directly.

Thus, even if it does not use the measured value to the light other than the 605 nm wavelength as optical transmissivity, if the optical transmissivity of light with a wavelength 605 nm is grasped, as for the performance of the sintered compact which comprises an aluminum nitride as the main ingredients according to this invention, that is, as for the crystallinity when forming the single crystal thin film which comprises as the main ingredients at least one or more materials selected from a gallium nitride, an indium nitride, and an aluminum nitride, it becomes easy to distinguish on behalf of it, when it uses as a substrate for light emitting device production further, for example, the luminous efficiency of the light emitting device produced can be judged.

In this invention, the optical transmissivity in the ultraviolet light of the range of 200 nm-380 nm wavelength means the optical transmissivity to one of the specific wavelength in the range of 200 nm-380 nm wavelength.

Unless reference is made especially in this invention, visible light is the light of the range of 380 nm-800 nm wavelength, and ultraviolet light means light with a wavelength not more than 380 nm.

Unless reference is made especially in this invention, using the sample of a disc-like sintered compact which comprises an aluminum nitride as the main ingredients and which has a diameter of 25.4 mm and thickness of 0.5 mm and was performed the specular surface polish (usually average surface roughness Ra=about 30 nm), and the optical transmissivity was expressed with the percentage ratio applying the light of predetermined wavelength to the above-mentioned sintered compact sample using the spectrophotometer etc., and measuring the intensity of a incidence light and a transmitted light.

Unless reference is made especially, as wavelength, usually it is measured using 605 nm.

Setting the above-mentioned test sample in the inside of an integrating sphere, and collecting all transmitted lights, and the optical transmissivity in this invention was calculated as total transmittance which expressed the intensity ratio of all transmitted lights and incident light with percentage.

Although the optical transmissivity of transparent bodies, such as glass, is usually called for as straight line transmissivity, incident light is scattered about inside a sintered compact, and generally the optical transmissivity of ceramic materials, such as a sintered compact which comprises an aluminum nitride as the main ingredients, is not penetrated linearly, but it is penetrated in all the directions in the condition of having been scattered about.

Therefore, the intensity of transmitted light becomes what collected all scattered light without such directivity.

In this invention, the optical transmissivity of the sintered compact comprising an aluminum nitride as the main ingredients and the other sintered compacts comprising a ceramic material as the main ingredients was measured as such total transmissivity, and it differs from the straight line transmissivity of transparent substances, such as glass.

Optical transmissivity changes with the thickness of a sample, when the above-mentioned sintered compact which comprises an aluminum nitride as the main ingredients according to this invention is actually used as a substrate for thin film formation, a thin film substrate, or a substrate for light emitting device production, it is effective to make thickness of this substrate thin and to raise optical transmissivity, if raising the luminous efficiency of a light emitting device.

Usually, it is preferred to use a thing with the thickness not less than 0.01 mm from the point of a handling strength as the substrate for thin film formation, a thin film substrate, or a substrate for light emitting device production.

Since optical transmissivity will tend to lower if thickness becomes thick, usually it is preferred to use a thing with the thickness not more than 8.0 mm as the substrate for thin film formation, a thin film substrate, or a substrate for light emitting device production.

If the range of the thickness of the above-mentioned sintered compact which comprises an aluminum nitride as the main ingredients in this invention is at least 0.01 mm -8.0 mm, it is effective if it has optical permeability in the condition that the substrate for thin film formation, the thin film substrate, or the substrate for light emitting device production is actually used.

That is, even if the thickness of the above-mentioned sintered compact which comprises an aluminum nitride as the main ingredients is the range of at least 0.01 mm -8.0 mm, or except it, optical transmissivity may just be at least not less than 1% in the state where it is actually used, for example, even if the thickness, such as 0.1 mm or 2.0 mm etc., is not actually 0.5 mm necessarily as a substrate for light emitting device production, the luminous efficiency of the produced light emitting device will tend to improve if it has optical permeability and optical transmissivity is at least not less than 1%.

Therefore, the optical transmissivity of the above-mentioned sintered compact which comprises an aluminum nitride as the main ingredients according to this invention is unrelated to the thickness of the sintered compact, and the optical permeability in the condition where this sintered compact is actually used is important, and it means the optical transmissivity in the condition where this sintered compact is actually used.

Optical transmissivity differs from the measurement at the time of the substrate thickness of 0.5 mm when the thickness of the sintered compact which comprises an aluminum nitride as the main ingredients is thinner than 0.5 mm at an actually used condition or is thicker than 0.5 mm, optical transmissivity tends to become high than the measurement at the time of 0.5 mm when thinner than 0.5 mm, it is easy to become lower than the optical transmissivity measured at the time of 0.5 mm when thicker than 0.5 mm.

In this invention, it is preferred to use the sintered compact which comprises an aluminum nitride as the main ingredients and whose optical transmissivity is not less than 1% in the above-mentioned condition actually used.

In this invention, as for the crystallinity of the single crystal thin film which comprises as the main ingredients at least one or more materials selected from a gallium nitride, an indium nitride, and an aluminum nitride and is formed on the substrate which consists of a sintered compact which comprises an aluminum nitride as the main ingredients, it is not necessarily required that the half width of the rocking curve of the X-ray diffraction line from the lattice plane of a Miller Index (002) is not more than 300 seconds.

For example, the one which has the crystallinity of the broad half width of the above-mentioned rocking curve of the X-ray diffraction can also be used satisfactorily for the uses, such as piezo-electric films for surface acoustic wave devices etc., an insulator film for wiring boards, a dielectric film, or an optical waveguide material.

If the half width of the above-mentioned rocking curve of the X-ray diffraction is not more than about 3600 seconds, it can be used satisfactorily for such use.

In the above-mentioned uses, as the crystallinity of the thin film which comprises as the main ingredients at least one or more materials selected from a gallium nitride, an indium nitride, and an aluminum nitride, according to the case, even if it is what is the crystallized states, such as an amorphous which is not necessarily a single crystal, a polycrystal, and an orientated polycrystal, it can be used.

However, when a light emitting device is formed on the single crystal thin film which comprises as the main ingredients at least one or more materials selected from a gallium nitride, an indium nitride, and an aluminum nitride and formed there by using the sintered compact which comprises an aluminum nitride as the main ingredients as a substrate, or when this single crystal thin film is used directly as a part of light emitting device constitution layer, or when this single crystal thin film is used as a cold cathode material of a field emission display (display by field emission), etc., as for the crystallinity of this single crystal thin film, it is preferred that the above-mentioned half width of the rocking curve of the X-ray diffraction line from the lattice plane of the Miller Index (002) is as sharp as not more than 300 seconds.

In this invention, the thin film which is various crystallized states containing the single crystal and comprises as the main ingredients at least one or more materials selected from a gallium nitride, an indium nitride, and an aluminum nitride can be formed directly on the substrate which consists of a sintered compact which comprises an aluminum nitride as the main ingredients.

Furthermore, in this invention, the thin film which is the various crystallized states containing the single crystal and comprises as the main ingredients at least one or more materials selected from a gallium nitride, an indium nitride, and an aluminum nitride can be formed on the substrate which consists of the above-mentioned sintered compact which comprises an aluminum nitride as the main ingredients as a constitution of two or more layers, when manufacturing a light emitting device.

The thin film formed in the two or more layers can be formed in the condition of differing, respectively, such as a crystallized state, composition, or thickness, in each class.

The thin film substrate by this invention which consists of a two or more-layer thin film layer consists of a single crystal thin film in which at least one or more of two or more-layer thin film layers comprises as the main ingredients at least one or more materials selected from a gallium nitride, an indium nitride, and an aluminum nitride.

When the thin film substrate by this invention will be used in order to form a single crystal thin film which comprises as the main ingredients at least one or more materials selected from a gallium nitride, an indium nitride, and an aluminum nitride, like the substrate for light emitting device formation, it is preferred that it is usually a single crystal as the thin film of the surface layer of a single crystal thin film substrate.

In this invention, also in the thin film of the various crystallized states containing the single crystal which comprises as the main ingredients at least one or more materials selected from a gallium nitride, an indium nitride, and an aluminum nitride and is being constituted with two or more layers, as for the single crystal thin film currently formed, what is sharp and high crystallinity, such that the half width of the rocking curve of the X-ray diffraction line from the lattice plane of the Miller Index (002) is not more than 300 seconds, is easy to be obtained.

The visible light or ultraviolet optical transmissivity of a substrate which consists of a sintered compact which comprises an aluminum nitride as the main ingredients changes by the complicated factor peculiar to a ceramic, such as, 1) sintered density, 2) the existence and size of the pore inside sintered compacts, 3) sintering-acid content, 4) oxygen contents, 5) impurities contents other than sintering aid and oxygen, 6) the size of the aluminum nitride particle in sintered compacts, or 7) the form of the aluminum nitride particle in sintered compacts, etc.

Usually, in the substrate which consists of a sintered compact which comprises an aluminum nitride as the main ingredients, if the aluminum nitride sintered compact has following nature, it has the tendency that the optical transmissivity in visible light becomes high to not less than 1%, 1) sintered density is high, 2) even if there are few pores inside a sintered compact and there are, size is small, 3) the amount of sintering aid is the required least amount, or sintering aid is not included, 4) there are few oxygen contents, 5) there are few impurities contents other than sintering aid or it does not contain, 6) the aluminum nitride particle in a sintered compacts is small, or magnitude is uniform, or 7) the aluminum nitride particle in a sintered compact which is not a round thing whose edge was smoothed out but a dense thing which is a polygon and has not a space at the surface of particles, the ridgeline, or the polygonal vertex by accompanying a overlap, or 8) what has few ingredients other than AlN, such as sintering aid, and has high AiN purity, even if the aluminum nitride particle in a sintered compact is large, 9) That the aluminum nitride particle grew greatly even if there were many ingredients other than AlN, such as sintering aids in a sintered compact.

Therefore, by using the substrate which consists of a sintered compact which has such nature and comprises an aluminum nitride as the main ingredients, the film quality and crystallinity of the single crystal thin film which comprises as the main ingredients at least one or more materials selected from a gallium nitride, an indium nitride, and an aluminum nitride tend to improve.

Originally, the thermal conductivity of a sintered compact which comprises an aluminum nitride as the main ingredients is at least not less than 50 W/mK in room temperature by controlling sintering aids or the amount of content oxygen or the other impure amount, usually it can be obtained the one of not less than 100 W/mK.

Therefore, since the light emitting device produced by using as a base material the sintered compact which comprises an aluminum nitride as the main ingredients can enlarge electric power applied there if it is compared with the case where the base material is sapphire, it has the advantage whose luminescence output of a light emitting device increases.

In the case of the sintered compact which comprises an aluminum nitride as the main ingredients, containing the above-mentioned sintering aid, or oxygen or other impurities, what has thermal conductivity not less than 150 W/mK in room temperature is obtained easily, so the input electric power to the light emitting device which is manufactured by using the sintered compact which comprises an aluminum nitride as the main ingredients as a base material can be heightened more, it is desirable.

In the case of the sintered compact which comprises an aluminum nitride as the main ingredients, containing the above-mentioned sintering aid, or oxygen or other impurities, what has thermal conductivity not less than 170 W/mK in room temperature is also obtained easily, so the input electric power to the light emitting device by using the sintered compact which comprises an aluminum nitride as the main ingredients as a base material can be heightened further, it is more desirable.

As for the substrate for forming directly the thin film which is the various crystallized states containing the single crystal and comprises as the main ingredients at least one or more materials selected from a gallium nitride, an indium nitride, and an aluminum nitride, this inventor has examined the sintered compact which comprises as the main ingredients a silicon carbide (SiC), a silicon nitride (Si₃N₄), an aluminum oxide (Al₂O₃), a zirconium oxide (ZrO₂), a zinc oxide (ZnO), a magnesium oxide (MgO), a beryllium oxide (BeO), a magnesium aluminate (MgAl₂O₄:spinel), etc. other than an aluminum nitride (AlN).

Among them, the thin film which comprises as the main ingredients at least one or more materials selected from a gallium nitride, an indium nitride, and an aluminum nitride, can be made into a single crystal by the sintered compact which has a hexagonal (Hexagonal) crystal structures, such as a silicon carbide, a silicon nitride, a zinc oxide, and a a beryllium oxide, etc., or a trigonal(Trigonal) crystal structure such as an aluminum oxide, etc.

In each substrate made from a sintered compact which comprises as the main ingredients a silicon carbide, a silicon nitride, a zinc oxide, a beryllium oxide, and an aluminum oxide, the half width of the rocking curve of the Miller-Index (002) lattice plane of a hexagonal system and trigonal system of this single crystal thin film formed on it tends to show the crystallinity not more than 3600 seconds.

On the other hand, the thin film which comprises as the main ingredients at least one or more materials selected from a gallium nitride, an indium nitride, and an aluminum nitride and is formed on the substrate which consists of a sintered compact which comprises as the main ingredients a zirconium oxide, a magnesium oxide, and a spinel is still the condition of polycrystal and cannot be made into a single crystal.

It is considered because the crystal system of zirconium oxide is a tetragonal system (Tetragonal) or a cubic system (Cubic) or a monoclinic system (Monoclinic), and magnesium oxide and spinel is a cubic system (Cubic) respectively.

Although the crystal system of an aluminum oxide is trigonal system, since the classification as a hexagonal system is also possible, this inventor thinks that the sintered compact which can make a thin film which is directly formed on it into a single crystal, is essentially after all only a substrate which comprises as the main ingredients the material whose crystal system is a hexagonal system and is able to classify as a hexagonal system.

Because the crystal structure of which a gallium nitride, an indium nitride, and an aluminum nitride each thin film has is a wurtzite type crystal, and the crystal system to which this wurtzite type crystal belongs is a hexagonal system, if the main ingredients of a sintered compact used as a substrate have the crystal structure which can be classified as a hexagonal system or a trigonal system, or which can be classified as a hexagonal system, it will be considered that each thin film of a gallium nitride, an indium nitride, and an aluminum nitride tends to easily be made into a single crystal.

n this invention, when the single crystal thin film which comprises as the main ingredients at least one or more materials selected from a gallium nitride, an indium nitride, and an aluminum nitride, is directly formed on the substrate using the sintered compact which comprises as the main ingredients the material which has the crystal system which can be classified as a hexagonal system, such as a silicon carbide, a silicon nitride, a zinc oxide, and a beryllium oxide etc., and has the crystal system which can be classified as a trigonal system or a hexagonal system, such as an aluminum oxide etc., it is realizable by using the substrate which consists of sintered compacts, such as the above-mentioned silicon carbide, the silicon nitride, the zinc oxide, the beryllium oxide, and the aluminum oxide, instead of the substrate which consists of a sintered compact which comprises an aluminum nitride as the main ingredients of the substrate 1 as shown in FIG. 1, FIG. 2, and FIG. 4.

In this case, the growth azimuth of this single crystal thin film is a perpendicular direction to a substrate surface, and tends to grow as a C axis of hexagonal system with which this thin film crystal belongs.

If an X-ray is irradiated, only the diffraction line from the lattice plane of the Miller Index (002) of this single crystal thin film will be detected the same with having been shown in FIG. 2.

The shape of the substrate which consists of the above-mentioned sintered compact which comprises as the main ingredients a silicon carbide, a silicon nitride, a zinc oxide, a beryllium oxide, and an aluminum oxide, etc. can use the thing of arbitrary shape, such as not only a round shape but a square, a rectangle, or other polygons, in this invention.

The substrate for thin film formation which consists of the above-mentioned sintered compact which comprises as the main ingredients a silicon carbide, a silicon nitride, a zinc oxide, a beryllium oxide, and an aluminum oxide, and the thin film substrate produced by using the sintered compact which comprises as the main ingredients a silicon carbide, a silicon nitride, a zinc oxide, a beryllium oxide, and an aluminum oxide, etc. can produce the one of arbitrary magnitude by using the method usually used in a sintered compact and thin film production.

That is, in the cases of a sintered compact, for example, the one which has a contour of 0.01 mm-1000 mm and a thickness of about 1 μm-20 mm is easily producible.

Among the substrate which consists of various sintered compacts which comprise a ceramic material as the main ingredients and which were examined in this invention, the substrate that consists of a sintered compact which comprises an aluminum nitride as the main ingredients is excellent especially.

In almost all the single crystal thin films which comprise as the main ingredients at least one or more materials selected from a gallium nitride, an indium nitride, and an aluminum nitride and were formed on the substrate which consists of the above-mentioned sintered compact which comprises an aluminum nitride as the main ingredients, the half width of the rocking curve of the X-ray diffraction line from the lattice plane of the Miller Index (002) of this single crystal thin film is as sharp as not more than 300 seconds, and it especially excels in crystallinity.

Therefore, it is big one of a background that such knowledge was acquired that this invention resulted in completion.

As for the sintered compact which comprises an aluminum nitride as the main ingredients, not only crystal system but also thermal expansion coefficient of is very close to the single crystal thin film and the thin film of various crystallized states, such as an amorphous state, a polycrystal, and an orientated polycrystal etc., which comprise as the main ingredients at least one or more materials selected from a gallium nitride, an indium nitride, and an aluminum nitride, and this inventor surmises that it is one of causes of excelling.

That is, a gallium nitride is 5.59×10⁻⁶ (degree-C-1), an indium nitride is 5.70×10⁻⁶ (degree-C-1), and an aluminum nitride is 5.64×10⁻⁶ (degree-C-1).

For example, forming the single crystal thin film of a gallium nitride at the temperature of about 1000 degrees C., using the sintered compact which comprises an aluminum nitride as the main ingredients, as a substrate for single crystal thin film formation according to this invention, and after cooling it to room temperature, the stress produced in a gallium nitride single crystal thin film is slight, and fault is not produced easily in a gallium nitride single crystal thin film.

It is guessed that the stress which is produced in a gallium nitride single crystal thin film in the case of this combination is served as compressive one, therefore fault stops being able to produce further easily in a gallium nitride single crystal thin film.

As mentioned above, as an advantage whose thermal expansion coefficient of a substrate is close to the single crystal thin film and the thin film of various crystallized states, such as an amorphous state, a polycrystal, and an orientated polycrystal etc., which comprise as the main ingredients at least one or more materials selected from a gallium nitride, an indium nitride, and an aluminum nitride, when the film thickness of a single crystal thin film and a thin film of various crystallized states, such as an amorphous state, a polycrystal, and an orientated polycrystal etc., which comprise as the main ingredients at least one or more materials selected from a gallium nitride, an indium nitride, and an aluminum nitride and is formed on a substrate needs to be thickened, since the stress produced in this single crystal thin film is small and the stress is also compressive stress in many cases, it is hard to produce faults, such as dislocation and a crack, in this thin film of various crystallized states, such as an amorphous state, a polycrystal, and an orientated polycrystal, and this single crystal thin film which have thick thickness not less than 10 μm, for example.

Thus, when the substrate which consists of a sintered compact which comprises an aluminum nitride as the main ingredients is used as a substrate for thin film formation, as for the single crystal thin film and the thin film of various crystallized states, such as an amorphous state, a polycrystal, and an orientated polycrystal etc., which are formed on this substrate and comprise as the main ingredients at least one or more materials selected from a gallium nitride, an indium nitride, and an aluminum nitride, though the thing whose thickness is arbitrary can be formed, the thing whose thickness is at least not less than 0.5 nm can be formed, and a thick thing not less than 10 μm can also be formed easily.

Thus, when the substrate which consists of a sintered compact which comprises an aluminum nitride as the main ingredients is used as a substrate for thin film formation, the thin film which comprises as the main ingredients at least one or more materials selected from a gallium nitride, an indium nitride, and an aluminum nitride and is formed on this substrate can form not only what is a single crystal but also what is various crystallinity, such as an amorphous state, a polycrystal, and an orientated polycrystal as a one of arbitrary thickness, it can be formed the thickness of at least not less than 0.5 nm, further, the thick thing of not less than 10 μm and the thing of not less than 50 μm can also be formed easily if needed.

In this invention, when the thickness of almost all the single crystal thin films which comprise as the main ingredients at least one or more materials selected from a gallium nitride, an indium nitride, and an aluminum nitride and were formed on the substrate which consists of the above-mentioned sintered compact which comprises an aluminum nitride as the main ingredients is not less than 0.5 nm (even if it is a single crystal thin film of not less than 10 μm, or not less than 50 μm), the half width of the rocking curve of the X-ray diffraction line from the lattice plane of the Miller Index (002) of this single crystal thin film is as sharp as not more than 300 seconds, and it especially excels in crystallinity.

Therefore, using the substrate according to this invention, when a light emitting device is formed by laminating the single crystal thin film which comprises as the main ingredients at least one or more materials selected from a gallium nitride, an indium nitride, and an aluminum nitride and the thin film which is various crystallized states, such as an amorphous state, a polycrystal, and an orientated polycrystal etc., there is little dislocation in a device, since the required thickness of a single crystal thin film and a thin film of various crystallized states, such as an amorphous state, a polycrystal, and an orientated polycrystal, and the thickness of the whole light emitting device can set arbitrarily in forming a light emitting device, layout of a light emitting device becomes easy and the light emitting device which has high luminous efficiency can be manufactured.

Thus, if the sintered compact which comprises an aluminum nitride as the main ingredients as a substrate is used, there is the feature that a high quality of the single crystal thin film and the thin film of various crystallized states, such as an amorphous state, a polycrystal, and an orientated polycrystal etc., which are formed on a substrate and comprise as the main ingredients at least one or more materials selected from a gallium nitride, an indium nitride, and an aluminum nitride is easy to be obtained, if it is compared with the sintered compact which comprises as the main ingredients a silicon carbide, a silicon nitride, a zinc oxide, a beryllium oxide, and an aluminum oxide, etc.

In addition, the secondary advantage in the case of using the sintered compact which comprises an aluminum nitride as the main ingredients as a substrate is the excellence of the transmissivity to ultraviolet light with a wavelength not more than 380 nm.

In the case of the sintered compact which comprises as the main ingredients a silicon carbide, a silicon nitride, a zinc oxides, a beryllium oxide, an aluminum oxides, etc. other than the sintered compact which comprises an aluminum nitride as the main ingredients, most transmissivity to ultraviolet light with a wavelength not more than 380 nm cannot be found, and it is 0% substantially.

Therefore, if the sintered compact which comprises an aluminum nitride as the main ingredients is used as a substrate, since the rate of the absorption of the ultraviolet light from a light emitting device by a substrate decreases, there is an advantage that the luminous efficiency of a light emitting device increases if it is compared with the sintered compact which comprises as the main ingredients a silicon carbide, a silicon nitride, a zinc oxide, a beryllium oxide, and an aluminum oxide, etc.

When the single crystal thin film which comprises as the main ingredients at least one or more materials selected from a gallium nitride, an indium nitride, and an aluminum nitride is formed by using such sapphire, a silicon carbide single crystal, or a silicon as the substrate, though these substrate materials are single crystals, in this single crystal thin film obtained, it is easy to produce curvature, a crack, or increase of dislocation, furthermore according to the case, this single crystal thin film may be unable to form thickly, it is also considered that the difference of thermal expansion coefficient to this single crystal thin film is one of the causes.

For example, among the above-mentioned single crystal substrate, the thermal expansion coefficient of a silicon carbide single crystal and silicon is smaller than the single crystal thin film and the thin film of various crystallized states, such as an amorphous state, a polycrystal, and an orientated polycrystal etc., which comprise as the main ingredients at least one or more materials selected from a gallium nitride, an indium nitride, and an aluminum nitride, therefore, tensile stress acts in this thin film, even if it forms this thin film by the comparatively thin thickness of 0.5 μm, it is easy to produce a crack and dislocation in this thin film.

As the substrate for forming the single crystal thin film which comprises as the main ingredients at least one or more materials selected from a gallium nitride, an indium nitride, and an aluminum nitride, as stated above, the single crystal was not necessarily excellent, even if it used the ceramic material as a substrate, as this inventor showed, an excellent single crystal thin film which comprises as the main ingredients at least one or more materials selected from a gallium nitride, an indium nitride, and an aluminum nitride can form.

The sintered compact which comprises an aluminum nitride as the main ingredients is excellent among the ceramic material, and a conventional problem can be solved.

According to this invention, the substrate for thin film formation and thin film substrate are not limited only to what formed directly the single crystal thin film which comprises as the main ingredients at least one or more materials selected from a gallium nitride, an indium nitride, and an aluminum nitride onto the substrate which consists of a sintered compact which comprises an aluminum nitride as the main ingredients and was illustrated in FIG. 1, FIG. 2, and a FIG. 4.

As for the substrate for thin film formation according to this invention, not only the substrate which consists of a sintered compact which comprises an aluminum nitride as the main ingredients is able to use, but also the substrate which consists of various sintered compacts which comprise as the main ingredients a ceramic material which has the crystal structure of a hexagonal system or a trigonal system, such as a silicon carbide, a silicon nitride, a beryllium oxide, a zinc oxide, and an aluminum oxide etc., and other various substrates which consist of a sintered compact which comprises a ceramic material as the main ingredients, are able to be used, and the thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal, can be formed directly on these substrates.

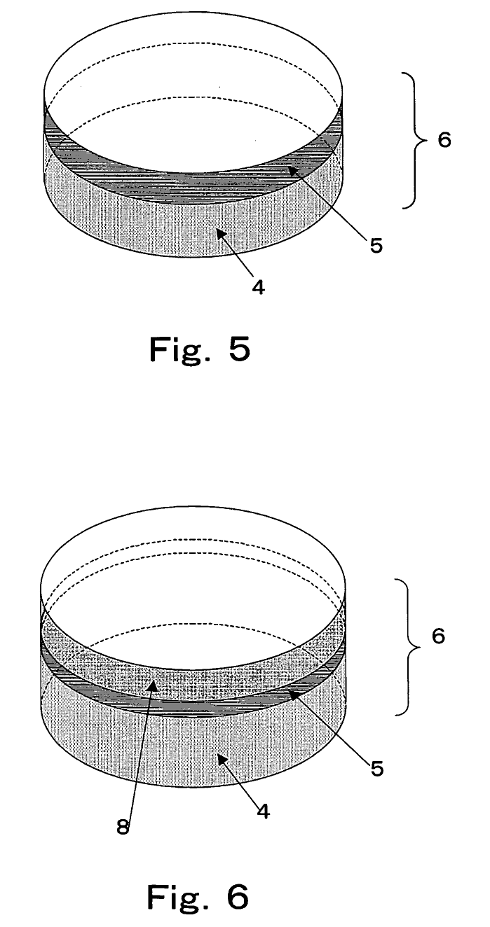

FIG. 5 is a perspective diagram about one example of the substrate for thin film formation and a thin film substrate according to this invention.

What was shown with the mark 4 in FIG. 5 is the substrate according to this invention, consisting of the sintered compact which comprises an aluminum nitride as the main ingredients, various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and other various sintered compacts which comprise a ceramic material as the main ingredients in addition to these, it is used as a substrate for thin film formation.

The thin film 5 which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed on this substrate 4, and the thin film substrate 6 is being constituted by this substrate 4 and the thin film 5.

The thin film 5 which comprises as the main ingredients at least one or more materials selected from a gallium nitride, an indium nitride, and an aluminum nitride and has at least one of the crystallized states selected from a single crystal, an amorphous state, a polycrystalline state, and an orientated polycrystalline state is being formed in this substrate 4.

Thin film 5 can be formed also as a thin film which is constituted with two or more layers which comprise as the main ingredients at least one or more materials selected from a gallium nitride, an indium nitride, and an aluminum nitride.

Among the thin films which consist of two or more layers in this invention, at least one or more layers are usually preferred, when the thing in which the thin film which comprises as the main ingredients at least one or more materials selected from a gallium nitride, an indium nitride, and an aluminum nitride and has the single crystal state was formed is used for various electronic devices, such as a substrate for light emitting device formation, the substrate for field emission, or dielectric materials for wiring boards, or an optical waveguide material, and an electronic-parts intended use.

As for the thin film on the surface of a substrate, it is more preferred that it is a single crystal among the thin films which comprised two or more above-mentioned layers.

The thin film 5 formed in two or more layers can be formed including a single crystal state in each class in the condition of differing, respectively, such as various crystallized states, such as an amorphous state, a polycrystalline state, and an orientated polycrystalline state, composition, or thickness.

That is, for example, it is the case whose thin film of a single crystal state is being formed furthermore on the thing in which the thin film which comprises as the main ingredients at least one or more materials selected from a gallium nitride, an indium nitride, and an aluminum nitride and is an amorphous state or an orientated polycrystalline state is formed beforehand on the substrate which consists of various sintered compacts which comprise a ceramic material as the main ingredients, including a sintered compact which comprises an aluminum nitride as the main ingredients, and various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc.

In this invention, it can be formed as a two-layer-thin film whose crystallized state is same and whose composition differs, respectively.

That is, for example, it can be formed as a two-layer-thin film whose formed thin film is a same single crystal, respectively and whose composition differs, respectively.

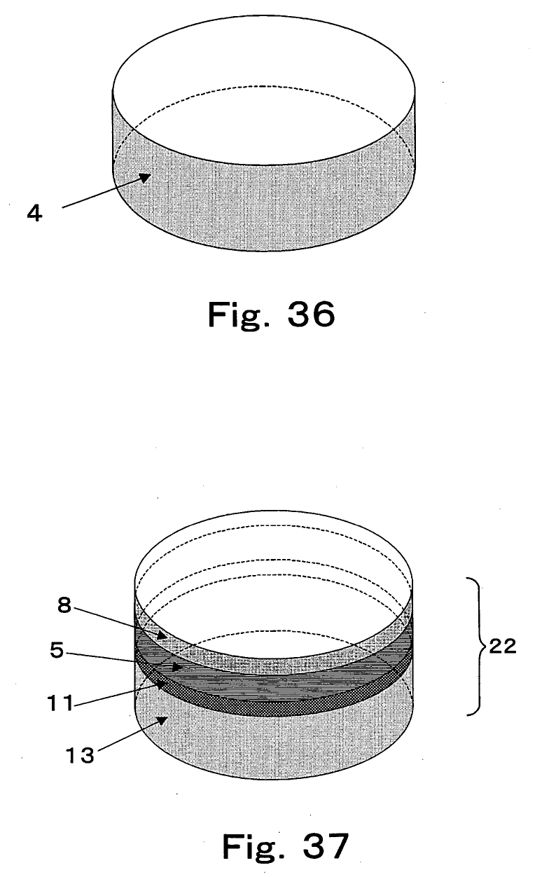

The drawing of only the substrate which consists of the sintered compact which comprises an aluminum nitride as the main ingredients, various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and other various sintered compacts which comprise a ceramic material as the main ingredients in addition to these, was illustrated in FIG. 36, and this substrate was shown with the mark 4 in it.

The substrate 4 illustrated to FIG. 36 is used as a substrate for thin film formation, and the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed on this substrate.

The thin film which comprises as the main ingredients at least one or more materials selected from a gallium nitride, an indium nitride, and an aluminum nitride can be formed directly, and the thin film which is various crystallized states such as a single crystal, an amorphous state, a polycrystal, and an orientated polycrystal can also be formed directly

on the substrate 4 which consists of various sintered compacts which comprise a ceramic material as the main ingredients, including a sintered compact which comprises an aluminum nitride as the main ingredients, and various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc.

As the embodiment in this invention, the thin film directly formed on the above-mentioned substrate 4 may not necessarily be the single crystal state which comprises as the main ingredients at least one or more materials selected from a gallium nitride, an indium nitride, and an aluminum nitride, the thin film currently formed directly may be at least one of the crystallized states selected from an amorphous state, a polycrystalline state, and an orientated polycrystalline state.

In this invention, by using the thin film substrate as shown in FIG. 5, the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal can be formed furthermore on it.

In that case, this thin film substrate will achieve the facility as a substrate for thin film formation.

Various electronic devices and electronic parts, such as a light emitting device, a field emission display, a wiring board, or an optical waveguide, are producible using the substrate for thin film formation and the thin film substrate which are according to this invention and which were illustrated in FIG. 5.

FIG. 6 is a perspective diagram which shows one example of the thin film substrate in which the thin film shown in FIG. 5 is being constituted with two layers.

In FIG. 6, what was shown with the mark 4 is the substrate which consists of various sintered compacts which comprise a ceramic material as the main ingredients according to this invention, including the sintered compact which comprises an aluminum nitride as the main ingredients, and the various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., it is used as a substrate for thin film formation.

In this substrate for thin film formation, the thin film 5 and thin film 8 which comprise as the main ingredients at least one or more materials selected from a gallium nitride, an indium nitride, and an aluminum nitride and have at least one of the crystallized states selected from a single crystal, an amorphous state, a polycrystal, and an orientated polycrystal are formed by one layer, respectively, and the thin film substrate 6 is being constituted with a thin film of a total of two layers.

The thin film 5 and thin film 8 which were illustrated in FIG. 6 comprise as the main ingredients at least one or more materials selected from a gallium nitride, an indium nitride, and an aluminum nitride and is the thin film of a single crystal state, or have at least one of the crystallized states selected from a amorphous state, a polycrystalline state, and an orientated polycrystalline state, if needed.

The thin film 5 and thin film 8 which were shown in FIG. 6 can be formed in the condition of differing in each class, such as crystallized states including a single crystal, such as an amorphous state, a polycrystal, and an orientated polycrystal, composition, or thickness, respectively.

In the thin film constitution shown in FIG. 6, if the thin film 5 is formed as at least one of the crystallized states which are selected from a single crystal, an amorphous state, a polycrystal, and an orientated polycrystal and if the thin film 8 is formed as an epitaxially grown single crystal, the crystallinity of this thin film 8 tends to improve than the crystallinity of the single crystal thin film directly formed on the substrate 4, it is preferred.

The thin film substrate of such thin film constitution is preferred when using it for various electronic devices, such as a light emitting device, field emission, a wiring board, or an optical waveguide, and production of electronic parts.

When forming the thin film 8 as an epitaxially grown single crystal as mentioned above, as the thin film 5 what formed as at least one of the crystallized states selected from an amorphous state, a polycrystal, and an orientated polycrystal is preferred, because what was excellent in the characteristics side of these thin films 8, such as crystallinity, is easy to be obtained, the thing in which the thin film 5 was formed as an orientated polycrystal is more preferred.

In this invention, not only what formed two layers of thin films as shown in FIG. 6 but the thin film substrate formed in three more or more layers can be provided easily.

Not all of the thin film shown in FIG. 5 and FIG. 6 as mentioned above are necessarily single crystals.

It is not necessarily a single layer.

The thin film shown in FIG. 5 and 6 can use the thing which comprises as the main ingredients at least one or more materials selected from a gallium nitride, an indium nitride, and an aluminum nitride and is the various crystallized states, such as a single crystal state, an amorphous state, a polycrystalline state, and an orientated polycrystalline state, etc.

Moreover, the thin film shown in FIG. 5 and 6 can be formed also as a thin film which is constituted with two or more layers which comprise as the main ingredients at least one or more materials selected from a gallium nitride, an indium nitride, and an aluminum nitride.

Although the thin film which consists of two or more layers can be formed in the state where the crystallized states, such as a single crystal state, an amorphous state, a polycrystalline state, and an orientated polycrystalline state etc., the composition, or the thickness differ respectively in each layer, in this invention, it is preferred that at least one or more layers are the single crystal which comprises as the main ingredients at least one or more materials selected from a gallium nitride, an indium nitride, and an aluminum nitride among the thin film which comprised two or more layers.

When the thin film substrate by this invention is used in order to form a thin film which comprises as the main ingredients at least one or more materials selected from a gallium nitride, an indium nitride, and an aluminum nitride and is the various crystallized states including a single crystal thin film, like the substrate for light emitting device formation, or the substrate for field emission, or the dielectric materials for wiring boards, or the material for optical waveguide, as for the surface of the thin film substrate according to this invention, it is preferred that it is usually a single crystal state.

A thin film substrate by this invention is a substrate in which the thin film which comprises as the main ingredients at least one or more materials selected from a gallium nitride, an indium nitride, and an aluminum nitride was formed on the substrate, using as a substrate the sintered compact which comprises an aluminum nitride as the main ingredients, the various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and the other various sintered compacts which comprise a ceramic material as the main ingredients, and it is a substrate in which at least a part of the thin films which comprise as the main ingredients at least one or more materials selected from a gallium nitride, an indium nitride, and an aluminum nitride comprises a epitaxially grown single crystal, if it requires.

In the thin film substrate by this invention, in case of what has the single crystal thin film which comprises as the main ingredients at least one or more materials selected from a gallium nitride, an indium nitride, and an aluminum nitride onto the surface, what formed furthermore the epitaxially grown thin film which comprises as the main ingredients at least one or more materials selected from a gallium nitride, an indium nitride, and an aluminum nitride onto it is desirable, after the thin film which comprises as the main ingredients at least one or more materials selected from a gallium nitride, an indium nitride, and an aluminum nitride and which has at least one of the crystallized states selected from a single crystal state, an amorphous state, a polycrystalline state, and an orientated polycrystalline state was formed beforehand on the various sintered compacts which comprise a ceramic material as the main ingredients, including the sintered compact which comprises an aluminum nitride as the main ingredients, and the various sintered compacts which comprise as the main ingredients a ceramic material and which have the crystal structure which can be classified as a hexagonal system, such as a silicon carbide, a silicon nitride, a zinc oxide, and a beryllium oxide etc., and classified as a trigonal system or a hexagonal system, such as an aluminum oxide, etc.

By doing so, since the crystallinity of a single crystal thin film improves than the thing which formed directly the single crystal which comprises at least one or more materials selected from a gallium nitride, an indium nitride, and an aluminum nitride as the main ingredients onto the sintered compact which comprises various ceramic materials, such as an aluminum nitride, as the main ingredients, it is desirable.

The thin film whose at least one part comprises a single crystal state which comprises as the main ingredients at least one or more materials selected from a gallium nitride, an indium nitride, and an aluminum nitride can be formed on the above-mentioned thin film substrate 6 shown in FIG. 5 and the thin film substrate 8 shown in FIG. 6, in addition the thin film of various crystallized states, such as an amorphous state, a polycrystal, and an orientated polycrystal, can also be formed.

As a substrate for thin film formation by this invention, it can use not only the substrate shown in FIG. 5 that consists of a sintered compact which comprises various ceramic materials, such as an aluminum nitride, as the main ingredients, but the substrate in which the thin film which comprises as the main ingredients at least one or more materials selected from a gallium nitride, an indium nitride, and an aluminum nitride was formed on the sintered compact which comprises an aluminum nitride as the main ingredients.

The substrate in which the thin film which comprises as the main ingredients at least one or more materials selected from a gallium nitride, an indium nitride, and an aluminum nitride was formed on such sintered compact which comprises an aluminum nitride as the main ingredients is same quality as the thin film substrate shown in FIG. 6, the thin film substrate by this invention can be used also as a substrate for thin film formation not only by an electronic device and electronic parts, such as dielectric materials for the substrate for light emitting device production, the substrate for field emission, or wiring boards, or a charge of optical waveguide material, but this invention.

In the thin film substrate by this invention, the sintered compact which comprises an aluminum nitride as the main ingredients and uses for forming a thin film which comprises as the main ingredients at least one or more materials selected from a gallium nitride, an indium nitride, and an aluminum nitride is usually used in the shape of a substrate.

This substrate-like sintered compact which comprises an aluminum nitride as the main ingredients has same quality as the substrate which consists of a sintered compact which comprises an aluminum nitride as the main ingredients and is used as a substrate for thin film formation according to this invention.

That is, the substrate for thin film formation according to this invention which consists of a sintered compact which comprises an aluminum nitride as the main ingredients can also be used as a substrate which constitutes the thin film substrate by this invention.

The substrate for thin film formation and thin film substrate which are indicated in FIG. 5 and 6 are disc-like, the thin film is drawn as being formed only in the 1 surface of a substrate, but in this invention, the above-mentioned thin film may be formed not only in the 1 surface of a substrate but in other surfaces if needed.

Moreover, for example, when a square-shaped board (rectangular parallelepiped) was used as the substrate for thin film formation and a thin film substrate, the thin film which comprises as the main ingredients at least one or more materials selected from a gallium nitride, an indium nitride, and an aluminum nitride can be formed on only 1 surface, or 2 surfaces, or 3 surfaces, or 4 surfaces, or 5 surfaces, or all 6 surfaces of the above-mentioned substrate for thin film formation and a thin film substrate, if needed.

The single crystal thin film 5 which comprises as the main ingredients at least one or more materials selected from the a gallium nitride, an indium nitride, and an aluminum nitride shown in FIG. 1, FIG. 2, a FIG. 4, FIG. 5, and FIG. 6 includes what is a single crystal state at least, necessity is accepted, it can form as what furthermore includes various crystallized states, such as an amorphous state, a polycrystalline state, and an orientated polycrystalline state, furthermore, this thin film 5 can be formed not only as a single layer but also as plural layers in which composition or a crystallized state or thickness differs.

According to this invention, as for manufacture, in the sintered compact which comprises an aluminum nitride as the main ingredients, and the substrate which consists of a sintered compact which comprises an aluminum nitride as the main ingredients, conventional methods can be used.

That is, it is manufactured by heating the powder compact which comprises an aluminum nitride as the main ingredients usually in the temperature range of about 1500-2400 degrees C. under ordinary pressure or under decompression or under pressurization of the non-oxidizing atmosphere, such as the neutral atmosphere which comprises as the main ingredients at least one or more materials, such as helium, neon, argon, and nitrogen, or the reduced atmosphere containing at least one or more materials, such as hydrogen, carbon monoxide, carbon, and hydrocarbon.

As for firing time, the range of about 10 minutes-3 hours is usually used.

It may be manufactured by firing in a vacuum.

Furthermore, it is manufactured by the hot-press method or HIP (Hot Isostatic Pressing).

As firing conditions by the hot-press method, the firing temperature range of about 1500-2400 degrees C. and the firing time range of about 10 minutes-3 hours and the pressure range of about 10 Kg/cm²-1000 Kg/cm² is usually used in the above-mentioned non-oxidizing atmosphere or a vacuum.

As firing conditions by the HIP method, the above-mentioned non-oxidizing atmosphere is pressurized at the range of about 500 Kg/cm²-10000 Kg/cm², and the firing temperature range of about 1500-2400 degrees C. and the firing time of the range of about 10 minutes-10 hours are usually used.

It is easy to obtain the sintered compact which comprises an aluminum nitride as the main ingredients and is more excellent in optical permeability if the device that an aluminum nitride ingredient exists in firing environments on the occasion of the above-mentioned firing is performed.

That is, it becomes easier to obtain the sintered compact which comprises an aluminum nitride as the main ingredients and is excellent in optical permeability if the vapor which comprises an aluminum nitride as the main ingredients exists in firing atmosphere.

As a method of making an aluminum nitride ingredient exist in firing atmosphere, for example, there is the method of supplying into atmosphere by evaporation from this fired thing itself during firing the powder compact which comprises an aluminum nitride as the main ingredients, or the sintered compact which comprises an aluminum nitride as the main ingredients, which are the fired thing, or supplying from other than this fired thing.

Concretely, for example, as the method of specifically supplying an aluminum nitride ingredient into firing environment from a fired thing itself, there are effects, that is, this fired thing is contained and fired in the firing container, such as the “saggar” and the “saggar”, or in the firing implement, such as the “setter”, which are produced with material which does not contain carbon as much as possible, such as boron nitride or tungsten, and molybdenum, or what carried out coating of the surface by boron nitride is used even if the firing container or firing implement containing carbon are used, etc.

The sintered compact which comprises an aluminum nitride as the main ingredients and is excellent in optical permeability is also producible by firing a fired thing, where the degree of sealing is raised further after containing in the firing container or the firing implement, etc.

As a method of specifically supplying an aluminum nitride ingredient into firing atmosphere from other than the fired thing, the sintered compact which comprises an aluminum nitride as the main ingredients and is excellent in optical permeability is producible by containing and firing the fired thing in the firing container, such as the “saggar” and the “saggar”, or in the firing implement, such as the “setter”, which are produced with material which comprises an aluminum nitride as the main ingredients.

The sintered compact which comprises an aluminum nitride as the main ingredients and is excellent in optical permeability tends to be acquired by the method of embedding a fired thing into the powder which comprises an aluminum nitride as the main ingredients, and firing it.

Even if they are fired with at least one or more things which are other than a fired thing and which are selected from the powder comprising an aluminum nitride as the main ingredients, the powder compact comprising an aluminum nitride as the main ingredients, or the sintered compact comprising an aluminum nitride as the main ingredients in the above-mentioned firing container or the firing implement, the sintered compact which comprises an aluminum nitride as the main ingredients and is excellent in optical transmissivity is producible.

It is suitable when firing extensive processing of a product and the thing of complicated form, since a fired thing can be fired in the free state by this method.

In addition, using the firing container or firing implement which are produced with the material which comprises an aluminum nitride as the main ingredients among the above-mentioned firing container or firing implement, even if they are fired with at least one or more things which are other than a fired thing and which are selected from the powder comprising an aluminum nitride as the main ingredients, the powder compact comprising an aluminum nitride as the main ingredients, or the sintered compact comprising an aluminum nitride as the main ingredients, the sintered compact which comprises an aluminum nitride as the main ingredients and is excellent in optical transmissivity is also producible.

In the method which produces the sintered compact comprising an aluminum nitride as the main ingredients and having excellent optical permeability by making the above-mentioned aluminum nitride ingredient exist in a firing atmosphere, usually, supplying from other than a fired thing can produce the sintered compact which comprises an aluminum nitride as the main ingredients and is more excellent in optical permeability than supplying this aluminum nitride ingredient into atmosphere by evaporation from the fired thing itself.

In addition, in the method of producing a sintered compact which comprises an aluminum nitride as the main ingredients and is excellent in optical permeability by making an aluminum nitride ingredient exist in firing atmosphere, usually, since it does not vaporize the ingredients while firing, such as additives like sintering aids and such as oxygen or unescapable impurities which are contained in a raw material, the sintered compact which comprises an aluminum nitride as the main ingredients and has the almost same composition as a powder compact is producible.

In addition, when firing by the hot-press method or the HIP method is performed, if this sintered compact which comprises an aluminum nitride as the main ingredients is re-fired under pressurization after this powder compact was pre-fired and was made into the sintered compact which comprises an aluminum nitride as the main ingredients, it is easy to obtain the sintered compact which comprises an aluminum nitride as the main ingredients and is more excellent in optical permeability, than firing under pressure the powder compact which comprises an aluminum nitride as the main ingredients as it is.

Also in firing by the hot-press method or the HIP method, when making an aluminum nitride ingredient exist in firing atmosphere by various methods, such as using the above-mentioned firing container and firing implement, it is desirable to produce the sintered compact which comprises an aluminum nitride as the main ingredients and is more excellent in optical permeability.

When raising the chemical purity of the sintered compact which comprises an aluminum nitride as the main ingredients, conditions other than the above can also be chosen if needed.

For example, if comparatively long time firing of not less than 3 hours is performed at the temperature not less than 1750 degrees C. in reduced atmosphere if required, since the contained oxygen or ingredients which are used as sintering aids such as a rare-earth compound and an alkaline earth metal compound or ingredient which are used as a firing temperature reduction-ized agents such as an alkali metal and silicon or metal ingredients which are used as black-ized agents such as Mo, W, V, Nb, Ta, Ti or carbon or unescapable metal ingredients other than Mo, W, V, Nb, Ta, Ti, etc. are able to be vaporized, removed, and decreased, the content of the metal ingredients, silicon, or compound containing carbon other than ALON or the above-mentioned aluminum is decreased and AlN purity increases, as the result, it becomes possible to manufacture the sintered compact whose optical permeability which comprises an aluminum nitride as the main ingredients improved.

As mentioned above, although the optical permeability of the sintered compact which comprises an aluminum nitride as the main ingredients can be raised more by performing long time firing of not less than 3 hours at the temperature not less than 1750 degrees C. in reduced atmosphere if required, the aluminum nitride particle tends to grow in the sintered compact which comprises an aluminum nitride as the main ingredients by this firing and this inventor is surmising that the decrease of particle boundaries is also one of the factors in which optical permeability becomes easy to increase, as the result.

When the single crystal thin film which comprises as the main ingredients at least one or more materials selected from a gallium nitride, an indium nitride, and an aluminum nitride is formed by using the sintered compact which raised AlN purity as mentioned above and comprises an aluminum nitride as the main ingredients as a substrate, the crystallinity of this single crystal thin film formed tends to become higher, it is preferred.

The aluminum nitride particle of a sintered compact which comprises an aluminum nitride as the main ingredients can be greatly grown up by performing firing, for example over 3 comparatively long or more hours at the temperature not less than 1750 degrees C.

When the thin film of the single crystal which comprises as the main ingredients at least one or more materials selected from a gallium nitride, an indium nitride, and an aluminum nitride by using as a substrate the sintered compact which comprises an aluminum nitride as the main ingredients in which the aluminum nitride particle grew is formed, since this single crystal thin film becomes easier to form a crystalline high thing, it is preferred.

In this invention, thus, not only the sintered compact which raised AlN purity and comprises an aluminum nitride as the main ingredients but also the sintered compact whose aluminum nitride particle grew and which comprises an aluminum nitride as the main ingredients are effective as a substrate for forming the thin film which comprises as the main ingredients at least one or more materials selected from a gallium nitride, an indium nitride, and an aluminum nitride.

As for the firing temperature when manufacturing the above sintered compact whose AlN purity is high and which comprises an aluminum nitride as the main ingredients or the sintered compact whose aluminum nitride particle grew and which comprises an aluminum nitride as the main ingredients, in order to shorten the firing time, not less than 1900 degrees C. is more preferred, not less than 2050 degrees C. is still more preferred, and not less than 2100 degrees C. is most preferred.

Of course, it is not less than 2050 degrees C., even if it is high temperature not less than 2100 degrees C., it can fire without sublimating most AlN ingredient itself.

In order to raise the purity of AlN or to make an aluminum nitride particle grow up, it is usually preferably to make the firing time not less than 10 hours in the range of a firing temperature of 1750 degrees C.-1900 degrees C., a bigger effect is acquired with not less than 24 hours.

In the firing temperature not less than 1900 degrees C., the effect of raising AlN purity enough or making an aluminum nitride particle grow up is acquired with firing time not less than 6 hours, and a bigger effect for raising the purity of AlN or growing up an aluminum nitride particle is acquired with not less than 10 hours.

In the firing temperature not less than 2050 degrees C., the effect of raising AlN purity enough or growing up an aluminum nitride particle is acquired with firing time not less than 4 hours, and a bigger effect of raising the purity of AlN or growing up an aluminum nitride particle is acquired with not less than 6 hours.

In the firing temperature not less than 2100 degrees C., the effect of raising AlN purity enough or growing up an aluminum nitride particle is acquired with firing time not less than 3 hours, and a bigger effect of raising the purity of AlN or growing up an aluminum nitride particle is acquired with not less than 4 hours.

When the AlN purity of a sintered compact which comprises an aluminum nitride as the main ingredients as mentioned above is raised, or when growing up an aluminum nitride particle, there is such a relation, if a firing temperature is raised a firing time can be shortened and if a firing temperature is made low a firing time becomes long, and a firing temperature and firing time can use arbitrary conditions.

As for the firing atmosphere when manufacturing the above-mentioned sintered compact which comprises an aluminum nitride as the main ingredients and has a high AlN purity, it is preferred to use the reduced atmosphere which contains at least one or more materials, such as hydrogen, carbon monoxide, carbon, and hydrocarbon, in order to make vaporization of impurities easier.

Although it may also be what comprises as the main substance at least one or more of hydrogen, carbon monoxide, carbon, and hydrocarbon, etc. as a reduced atmosphere, for example, it may be the atmosphere which contains very small amount of about 0.1 ppm of at least one or more of hydrogen, carbon monoxide, carbon, and hydrocarbon, etc. in the ambient atmosphere which comprises as the main ingredients at least one or more of nitrogen, helium, neon, and argon, etc.

When the reduced atmosphere is an atmosphere which contains at least one or more of very small amount of hydrogen, carbon monoxide, carbon, and hydrocarbon, etc. in the ambient atmosphere which comprises at least one or more of nitrogen, helium, neon, argon, etc. as the main substance, what contains at least one or more of hydrogen, carbon monoxide, carbon, and hydrocarbon, etc. not less than 10 ppm is more preferred, in order to make the sintered compact which comprises an aluminum nitride as the main ingredients high purity.

In the above-mentioned reduced atmosphere, what contains at least one or more of hydrogen, carbon monoxide, carbon, and hydrocarbon, etc. not less than 100 ppm is still more desirable, in order to make the sintered compact which comprises an aluminum nitride as the main ingredients high purity.

There is especially no need to use reduced atmosphere as the ambient atmosphere when manufacturing the sintered compact whose aluminum nitride particle which comprises an aluminum nitride as the main ingredients grew, and it is enough if it is a non-oxidizing atmosphere.

When manufacturing the sintered compact which comprises an aluminum nitride as the main ingredients and has a high AlN purity or the sintered compact which comprises an aluminum nitride as the main ingredients and whose aluminum nitride particle grew up by performing the above comparatively long time firing, it may be fired by using the powder compact which comprises an aluminum nitride raw material powder as the main ingredients, and what was made into the sintered compact by pre-firing the above-mentioned powder compact may be used.

It is also preferred to use the powder compact and a sintered compact which comprise an aluminum nitride as the main ingredients containing at least one or more materials selected from a rare-earth compound or an alkaline earth metal compound other than aluminum nitride which is a main ingredient.

When manufacturing the sintered compact which comprises an aluminum nitride as the main ingredients and has a high AlN purity, the powder compact and sintered compact which used raw material powder as it is are used especially without sintering aids, preferably, although the ingredient contained may be vaporized and removed by heating for not less than 3 hours at the temperature not less than 1750 degrees C. among the above reduced atmospheres, if using the powder compact and sintered compact which comprise an aluminum nitride as the main ingredients and contain at least one or more materials selected from a rare-earth compound or an alkaline earth metal compound as mentioned above, ingredients other than AlN are vaporized, removed, and reduced, so high purification is easy to be attained, it is more desirable.

And, by using the powder compact which comprises an aluminum nitride as the main ingredients and contained simultaneously at least one or more compounds selected from a rare earth element compound and at least one or more compounds selected from an alkaline-earth-metals compound, or by using what once fired the powder compact and was made into the sintered compact, it becomes possible to lower a firing temperature by about 50 degrees C.-300 degrees C. if it is compared with the case where a rare-earth compound or an alkaline earth metal compound is used alone, respectively, ingredients other than AlN is effectively vaporized, removed, and reduced, so high purification is easy to be attained, it is more desirable.

The aluminum nitride sintered compact which consists of an AlN single phase substantially by the analysis using methods, such as X-ray diffraction, by such method can also be manufactured.

It is effective to raise the AlN purity of the sintered compact which comprises an aluminum nitride as the main ingredients and uses as a substrate for thin film formation in this invention, in order to raise the quality of the thin film which comprises as the main ingredients at least one or more materials selected from a gallium nitride, an indium nitride, and an aluminum nitride and forms on this substrate.

As the reason, it seems that the area which a grain boundary phase occupies in a sintered compact will be decreased so it will become to be influenced only of an AlN particle.

However, on the other hand, it is effective to use the sintered compact which comprises an aluminum nitride as the main ingredients in which the aluminum nitride particle grew as a substrate.

That is, for example, as for the sintered compact which comprises an aluminum nitride as the main ingredients and is obtained by firing the above-mentioned powder compact and sintered compact for comparatively long hours of not less than 3 hours at the temperature not less than 1750 degrees C., while the aluminum nitride particle is growing greatly, comparatively many ingredients, such as sintering aid, such as a rare-earth compound and an alkaline earth metal compound, or oxygen, or ingredients used as a firing temperature reduction-ized agent, such as an alkali metal and silicon, or the metal ingredients, such as Mo, W, V, Nb, Ta, and Ti and carbon which are used as a black-ized agent, or unescapable metal ingredients other than Mo, W, V, Nb, Ta, and Ti, or ALON and metal ingredients other than the above-mentioned aluminum, and silicon, or the compound containing carbon, etc., may remain.

Even if it uses such sintered compact as a substrate, the quality of a thin film improves, for example, the crystallinity of the single crystal thin film which comprises as the main ingredients at least one or more materials selected from a gallium nitride, an indium nitride, and an aluminum nitride and is formed on this substrate improves.

That is, in this invention, even if the AlN purity of the sintered compact which comprises an aluminum nitride as the main ingredients and is used as a substrate for forming the thin film which comprises as the main ingredients at least one or more materials selected from a gallium nitride, an indium nitride, and an aluminum nitride is not necessarily high, it is shown that it is effective to enlarge the aluminum nitride particle in a sintered compact.

As the reason, since grain boundaries will decrease in number if the size of the aluminum nitride crystal grain in a sintered compact increases, the effect of a grain boundary decreases, it is surmised that this AlN particle which increased greatly becomes easy to produce the characteristic near a single crystal.

If it fires at high temperature as mentioned above for a long time, the size of the aluminum nitride crystal grain in a sintered compact will increase, but the AlN purity in the sintered compact which comprises an aluminum nitride as the main ingredients usually tends to increase in it simultaneously.

In order to control improvement in AlN purity only by increasing the size of an aluminum nitride crystal grain in the sintered compact which comprises an aluminum nitride as the main ingredients, it is preferred to use non-oxidizing atmosphere, such as nitrogen and argon, etc., which have comparatively little of reduction nature ingredient, such as hydrogen, carbon monoxide, carbon, and hydrocarbon, as firing environment.

Also as for a firing furnace, other than the method using carbon heating element, the method which makes carbon generate heat by electromagnetic induction, or what has a furnace material made from carbon, etc., for example, it is effective to use what is the method using high melting point metals, such as tungsten and molybdenum, as a heating element or the method which makes high melting point metals, such as tungsten and molybdenum, generate heat by electromagnetic induction, or what uses the furnace material made from high melting point metals, such as tungsten and molybdenum.

Even if it fires in reduced atmosphere including hydrogen, carbon monoxide, carbon, and hydrocarbon, etc. or uses the method which uses carbon heating element and the firing furnace which makes carbon generate heat by electromagnetic induction, it is also effective to fire in the state where it was isolated as much as possible from the reduced atmosphere by containing the above-mentioned powder compact and sintered compact in a setter, an implement, or a saggar who do not include carbon as much as possible, such as an aluminum nitride, boron nitride, or tungsten, or embedding into an aluminum nitride powder, or embedding into an aluminum nitride powder even if it uses a setter, an implement, or a sagger who include carbon, or containing in the above setter, firing implement, or sagger and further embedding into an aluminum nitride powder, etc.

Without using the above firing method which controls the high purification of a sintered compact, if the above-mentioned powder compact or sintered compact is fired by using the method using carbon heating element, the method which makes carbon generate heat by electromagnetic induction, or the furnace using the furnace material made from carbon etc., or by using a setter, an implement, or a sagger which are made from carbon, since the reduced atmosphere which contains carbon monoxide and carbon is easy to be formed spontaneously, the ingredients other than AlN evaporate and become easy to be removed, so the sintered compact which comprises an aluminum nitride as the main ingredients and has a high AlN purity and whose aluminum nitride particle grew up can be obtained easily, it is desirable.

Usually, it is desirable to fire the above-mentioned powder compact or sintered compact by using the method using carbon heating element, the method which makes carbon generate heat by electromagnetic induction, or the furnace using a furnace material made from carbon etc., and using simultaneously the setter, firing implement, or sagger which are made from carbon, in order to manufacture the sintered compact which comprises an aluminum nitride as the main ingredients and has a high AlN purity and whose aluminum nitride particle grew up.

Moreover, as mentioned above, the sintered compact which comprises an aluminum nitride as the main ingredients and which has comparatively little increase of the size of an aluminum nitride crystal grain and is the state where comparatively much impurities, sintering aids, etc. remained, by performing the firing for comparatively short time not more than 3 hours in the above-mentioned non-oxidizing atmosphere which is weak in reduction nature or does not contain a reduction ingredient or at comparatively low temperature of, for example, not more than 1900 degrees C. in non-oxidizing atmosphere which is weak in reduction nature or does not contain reduction nature ingredient, is also used satisfactorily as a substrate for forming the thin film which comprises as the main ingredients at least one or more materials selected from a gallium nitride, an indium nitride, and an aluminum nitride.

That is, in the sintered compact which comprises an aluminum nitride as the main ingredients and is produced like that, oxygen impurities in raw material powder, and oxygen which is resulting from A₂O₃ which is added to the powder compact, or a metal ingredient and an oxygen ingredient etc. which are in the added sintering aids such as a rare-earth compound and an alkaline earth metal compound, or the metal ingredient, a silicon ingredient, an oxygen ingredient, etc. in the added alkali metal compound and a silicon content compound, or the added compound containing each transition metals of Mo, W, V, Nb, Ta, and Ti and a metal ingredient and a carbon ingredient, etc. in the added compound which contains carbon, or a metal ingredient and an oxygen ingredient, etc. in the added compound which contains unescapable impurities, such as Fe, nickel, Cr, Mn, Zr, Hf, Co, Cu, Zn, etc., they are hardly vaporized and removed by firing, the almost same quantity as the inside of a powder compact exist in many cases.

On the other hand, unless reference is made especially in this invention, as for the quantity of the impurities contained in the powder compact and the sintered compact which comprises an aluminum nitride as the main ingredients, or the various additives which were added in, they are shown as the amount of oxide conversions or the amounts of element conversions of a compound, such as impurities actually contained in or sintering aid added in, the quantity of the oxygen ingredient, metallurgy group ingredient, or silicon ingredient of the above-mentioned sintered compact which comprises an aluminum nitride as the main ingredients is usually based on oxide conversion or element conversion.

As mentioned above, although the sintered compact which comprises an aluminum nitride as the main ingredients, in which the AlN purity is high and the aluminum nitride particle grew, is preferred as a substrate for thin film formation, even if the purity of AlN is not necessarily high, that is, even if the sintered compact which comprises an aluminum nitride as the main ingredients is what has comparatively many residual ingredients, such as the sintering aids such as a rare-earth compound and an alkaline earth metal compound, or oxygen, or the ingredients used as a firing temperature reduction-ized agent such as an alkali metal and silicon, or the metal ingredients and carbon which are used as a black-ized agent such as Mo, W, V, Nb, Ta, and Ti, or the unescapable metal ingredients other than Mo, W, V, Nb, Ta, and Ti, such as Fe, nickel, Cr, Mn, Zr, Hf, Co, Cu, and Zn, or ALON or the compound containing metal ingredients, silicon, or carbon other than the above-mentioned aluminum, if it is the thing whose aluminum nitride particle grew, it can become the substrate in which the single crystal thin film which has high crystallinity and comprises as the main ingredients at least one or more materials selected from a gallium nitride, an indium nitride, and an aluminum nitride can form.

While the above impurities remain, and even if it is the sintered compact which comprises an aluminum nitride as the main ingredients and whose aluminum nitride particle has grown, it does not necessarily have optical permeability, or is not small, what has the high optical transmissivity of 60% -80% is obtained.

Such sintered compact which comprises an aluminum nitride as the main ingredients can serve as an outstanding substrate which can form the single crystal thin film of high crystallinity which comprises as the main ingredients at least one or more materials selected from a gallium nitride, an indium nitride, and an aluminum nitride.

As for the sintered compact which comprises an aluminum nitride as the main ingredients and has such high AlN purity, or the sintered compact which comprises an aluminum nitride as the main ingredients and whose aluminum nitride particles grew up, or the sintered compact which comprises an aluminum nitride as the main ingredients and has a high AlN purity and whose aluminum nitride particles grew up, the optical transmissivity of visible light or ultraviolet light will increase.

The secondary effect whose thermal conductivity can also improve into not less than 200 W/mK in room temperature or not less than 220 W/mK is brought about.

The thermal conductivity of the sintered compact which comprises an aluminum nitride as the main ingredients originally is at least not less than 50 W/mK in room temperature, usually it is as high as not less than 100 W/mK, therefore, since the light emitting device produced using the sintered compact which comprises an aluminum nitride as the main ingredients as a base material can enlarge electric power applied there if it is compared with the case where the substrate is sapphire, it has the advantage that the emitting output of a light emitting device increases, but can heighten the emitting output of a light emitting device further by raising thermal conductivity to not less than 200 W/mK in room temperature by the above methods further, for example, and is more preferred.

Moreover, as for the above-mentioned sintered compact which comprises an aluminum nitride as the main ingredients and has a high AlN purity or the sintered compact which comprises an aluminum nitride as the main ingredients and whose aluminum nitride particles grew up, since the optical transmissivity in visible light and/or the ultraviolet light of the range of 200 nm-380 nm wavelength increases and what has a comparatively high optical transmissivity not less than 20-40% is easy to be obtained, the rate whose light from a light emitting device is absorbed by a substrate decreases, and it also has another advantage whose luminous efficiency of a light emitting device increases.

In order to raise the optical transmissivity of the above-mentioned sintered compact which comprises an aluminum nitride as the main ingredients and whose high purification was attained, although the form of the powder compact and a sintered compact which are provided to firing can use any one, if it is the same volume, it is more preferred to use what has bigger surfacel area, for example, a shape of a board than a block shape, such as a cube, a rectangular parallelepiped, or a cylindrical one, etc.

If what is the one-side size of not more than 8 mm is used as the form of the powder compact and a sintered compact which are provided to the above-mentioned firing, it is desirable in order to raise the optical transmissivity of the sintered compact which comprises an aluminum nitride as the main ingredients and was made into high purity.

Moreover, it is more preferred to use the thing in which the above-mentioned one side magnitude is not more than 5 mm, it is still more preferred to use the thing in which the one side magnitude is not more than 2.5 mm, and it is most preferred to use the thing in which the one side magnitude is not more than 1 mm.

When the form of the powder compact and a sintered compact which are provided to the above-mentioned firing is board-like, it is desirable to use what is the thickness not more than 8 mm in order to raise the optical transmissivity of the sintered compact which comprises an aluminum nitride as the main ingredients and was made into high purity.

It is more preferred to use a thing of not more than 5 mm as the thickness of the above-mentioned board-like powder compact and a sintered compact, it is still more preferred to use a thing with the thickness not more than 2.5 mm, and it is most preferred to use a thing with the thickness not more than 1 mm.

If what was shown above is described concretely, for example, even if the sintered compact comprises the substantially same composition and substantially AlN single phase, when the sintered compact which comprises an aluminum nitride as the main ingredients and whose high purification was attained is manufactured by using what has the block-like shape such as the above-mentioned cube and rectangular parallelepiped, or the cylindrical one, or the powder compact and sintered compact which have the one side size of exceeding 5 mm, optical transmissivity lowers if it is compared with what manufactured using the compact and sintered compact which have the shape of a board or one side size of not more than 8 mm, it may black-ize according to the case and optical transmissivity may become near zero.

Although the reason is not necessarily clear, it is guessed that when ingredients other than AlN are vaporized and removed in process of the firing, the pressure of this vaporization ingredient increases and it is extracted from a sintered compact rapidly, or the minor constituent which can be hard to distinguish by X-ray diffraction or a chemical analysis changes into a reduction product, such as the nitride and carbide, etc., during vaporization of sintering aid, such as Y₂O₃ etc.

By using the above illustrated method, the characters of a sintered compact which comprises an aluminum nitride as the main ingredients are controllable, such as, 1) the degree of densification, and 2) the quantity and size of pores, 3) the quantity and distribution of sintering aids, etc., 4) the content and an existence condition of oxygen, 5) the quantity and distribution of impurities other than sintering aids, 6) the size of an aluminum nitride particle and particle size distribution, and 7) the form of aluminum nitride particle, etc.

As mentioned above, as for the sintered compact which was manufactured by the firing method whose ingredients other than the aluminum and nitrogen which are contained will be vaporized and removed, there is the feature that optical permeability becomes high, AlN purity also becomes high, and the size of an aluminum nitride particle also becomes large, if it is compared with what was manufactured by the usual firing method (including the above-mentioned methods, such as under decompression, under normal pressure, under pressurization atmosphere, hot press, and HIP, etc.).

Although such sintered compact is a polycrystalline substance, since the influence of a grain boundary decreases and it approaches to the quality of a single crystal, the crystallinity of the single crystal thin film formed on what used this sintered compact as a substrate increases, etc., the quality of the thin film which comprises as the main ingredients at least one or more materials selected from a gallium nitride, an indium nitride, and an aluminum nitride tends to improve.

This invention also provides the sintered compact which comprises an aluminum nitride as the main ingredients, raised the AlN purity and is manufactured by the firing method whose high purification is the aim, or the sintered compact which comprises an aluminum nitride as the main ingredients and whose size of an aluminum nitride particle was grown up, or the sintered compact which comprises an aluminum nitride as the main ingredients and raised the AlN purity and whose size of an aluminum nitride particle was grown up.

As for the raw material powder for the manufacture of the above-mentioned sintered compact which comprises an aluminum nitride as the main ingredients, what was produced by the method of oxide reduction which reduces an aluminum oxide by carbon and is nitrided, or the direct nitriding method which nitrides metal aluminum directly, or the CVD method which decomposes aluminium compounds, such as aluminium chloride, trimethyl aluminum, and aluminum alkoxide, and is nitrided using ammonia etc. in the gaseous phase, is used.

In order to raise the transmissivity of a sintered compact, it is preferred to use the raw material which has a uniform submicron primary particle and was produced by the method of oxide reduction with chemical high purity.

Therefore, among the raw materials by the above-mentioned method, it is preferred that the thing made by the method of oxide reduction which reduces an aluminum oxide by carbon and is nitrided or the thing made by the direct nitriding method which nitrides metal aluminum directly are used alone or in the mixed state.

As for the optical transmissivity of the sintered compact which comprises an aluminum nitride as the main ingredients, what is about 60-80%, or not less than 80-90% is obtained by using the above-mentioned manufacturing process suitably.

If the sintered compact which comprises an aluminum nitride as the main ingredients and has the optical transmissivity not less than 40% is used as a substrate, as for the crystallinity of the single crystal thin film which comprises as the main ingredients at least one or more materials selected from a gallium nitride, an indium nitride, and an aluminum nitride and was directly formed on this substrate, the good thing, such that the half width of the rocking curve of the X ray diffraction line from the lattice plane of a Miller Index (002) is not more than 150 seconds, is easy to be obtained, and it is preferred.

And, if the sintered compact which comprises an aluminum nitride as the main ingredients and has a high optical transmissivity not less than 60% is used as a substrate, as for the crystallinity of the single crystal thin film which comprises as the main ingredients at least one or more materials selected from a gallium nitride, an indium nitride, and an aluminum nitride, the good thing, such that the half width of the rocking curve of the X ray diffraction line from the lattice plane of a Miller Index (002) is not more than 130 seconds, is easy to be obtained, and it is especially preferred.

And, if the sintered compact which comprises an aluminum nitride as the main ingredients and has a high optical transmissivity not less than 80% is used as a substrate, as for the crystallinity of the single crystal thin film which comprises as the main ingredients at least one or more materials selected from a gallium nitride, an indium nitride, and an aluminum nitride, the good thing, such that the half width of the rocking curve of the X ray diffraction line from the lattice plane of a Miller Index (002) is not more than 100 seconds, is easy to be obtained, and it is the most preferred.

Although the above-mentioned optical transmissivity is usually measured by monochromatic light with a wavelength 605 nm , the sintered compact which comprises an aluminum nitride as the main ingredients and has the optical transmissivity measured by the above-mentioned method has the same transmissivity also in all the visible light areas of the range of 380 nm-800 nm wavelength.

The sintered compact which comprises an aluminum nitride as the main ingredients and has such optical transmissivity of visible light has high transmissivity also in the light of the ultraviolet region of the range of 200 nm-380 nm wavelength, and has higher transmissivity in the light of the range of 250 nm-380 nm wavelength in the light of this ultraviolet region.

In this invention, since a substrate is the sintered compact which comprises an aluminum nitride as the main ingredients, the crystal orientation of the aluminum nitride particle in a sintered compact has turned to the random direction.

Therefore, although the aluminum nitride particle in this above sintered compact which comprises an aluminum nitride as the main ingredients is the same wurtzite type crystal structure as a gallium nitride or an indium nitride and its lattice constant is also almost the same, it cannot be said that lattice matching is carried out in the theoretical view hitherto called between the substrate and the single crystal thin film which comprises as the main ingredients at least one or more materials selected from a gallium nitride, an indium nitride, and an aluminum nitride.

Thus, in spite of it seeming that lattice matching cannot be theoretically carried out with a substrate, the thin film formed on a substrate is a single crystal.

Although this inventor actually tried to form a thin film which comprises as the main ingredients at least one or more materials selected from a gallium nitride, an indium nitride, and an aluminum nitride in the comparatively thin thickness of about 0.5-5 nm on the substrate which consists of a sintered compact which comprises an aluminum nitride as the main ingredients, at least the thin film which comprises as the main ingredients a gallium nitride and an indium nitride is a single crystal thin film which has good crystallinity not more than 300 seconds as half width of the rocking curve of the X-ray diffraction line from the lattice plane of a Miller Index (002).

It is judged with a thin film with an above-mentioned thickness of 0.5-5 nm which comprises an aluminum nitride as the main ingredients being a single crystal in electron diffraction.

Even if it is what formed thickly to 3-6 μm and not less than 10 μm as the thickness of the thin film which comprises as the main ingredients at least one or more materials selected from a gallium nitride, an indium nitride, and an aluminum nitride, what is good crystallinity not more than 300 seconds as half width of the rocking curve of the X-ray diffraction line from the lattice plane of a Miller Index (002) is obtained.

Furthermore, according to the characteristic as shown in the -following of the sintered compact which comprises an aluminum nitride as the main ingredients in addition to optical transmissivity of visible light, it can also make the crystallinity of the single crystal thin film which comprises as the main ingredients at least one or more materials selected from a gallium nitride, an indium nitride, and an aluminum nitride and was formed on a substrate into the better thing of not more than 300 seconds -150 seconds as half width of the rocking curve of the X-ray diffraction line from the lattice plane of a Miller Index (002).

A single crystal thin film which comprises as the main ingredients at least one or more materials selected from a gallium nitride, an indium nitride, and an aluminum nitride can be formed using the substrate which consists of a polycrystalline substance called the sintered compact which comprises an aluminum nitride as the main ingredients according to this invention, but it is not necessarily clear about the cause at present.

Even if an aluminum nitride particulate has completely random directivity in the inside of a sintered compact, when the gas ingredient which comprises as the main ingredients at least one or more materials selected from a gallium nitride, an indium nitride, and an aluminum nitride changes from gas to a solid state and nuclear growth starts on a sintered compact, it aligns in the direction of C axis all at once, and it is surmised that it has originally the characteristic which is easy to become a single crystal probably by the chemical entity which is aluminum nitride and the crystal structure in which itself has.

Namely, it is surmised that it is because aluminum nitride which is the main ingredients in a sintered compact originally has strongly the characteristic which helps single crystallization of a thin film in itself, in process, wherein an ingredient which comprises as the main ingredients at least one or more materials selected from a gallium nitride, an indium nitride, and an aluminum nitride is changed from gas to a solid, and a thin film is formed onto the substrate which consists of a sintered compact which comprises an aluminum nitride as the main ingredients.

Although single crystal-ization of this thin film can be attained even if a substrate is the sintered compact which comprises as the main ingredients a silicon carbide, a silicon nitride, an aluminum oxide, a zinc oxide, and a beryllium oxide, etc. which belong to the crystal system of the same hexagonal system as an aluminum nitride or the trigonal system, in the crystallinity of the formed thin film, the validity of the above-mentioned guess can explain indirectly also from the excellence of the thing formed directly on the substrate which used the sintered compact which comprises an aluminum nitride as the main ingredients.

And, as for the thin film which passed through the process changed into a solid film which comprises as the main ingredients at least one or more materials selected from a gallium nitride, an indium nitride, and an aluminum nitride after once passing through the gas, ion, a single molecule, or a molecular beam containing the ingredient which can form at least one or more materials selected from a gallium nitride, an indium nitride, and an aluminum nitride, what became a single crystal state as a thin film is easy to be obtained.

In this invention, since the single crystal thin film which comprises as the main ingredients at least one or more materials selected from a gallium nitride, an indium nitride, and an aluminum nitride becomes easy to be formed on a substrate directly by using as a substrate the sintered compact containing an aluminum nitride not less than 50 volume %, it is desirable.

The content of the aluminum nitride in the substrate which consists of a sintered compact which comprises an aluminum nitride as the main ingredients is easily reckonable by calculating the content of ingredients other than aluminum, such as a rare-earth compound, an alkaline earth metal compound, oxygen, an alkali metal, silicon, and metal ingredients of Mo, W, V, Nb, Ta, Ti, etc., carbon, unescapable metal ingredients other than Mo, W, V, Nb and Ta, and Ti, ALON, and the above-mentioned metal ingredients other than aluminum, contained in a sintered compact, as element conversion respectively.

In addition, oxygen is what was converted as an aluminum oxide.

The above-mentioned guess can be explained to some extent, since correlation is seen between the crystallinity of the single crystal thin film which is formed on a substrate and comprises as the main ingredients at least one or more materials selected from a gallium nitride, an indium nitride, and an aluminum nitride, and the transmissivity of a sintered compact which comprises an aluminum nitride as the main ingredients.

Namely, although the transmissivity of a sintered compact which comprises an aluminum nitride as the main ingredients changes by the factors, such as 1) the density of a sintered compact, 2) the existence and the size of the pore inside sintered compacts, 3) the content of the sintering aids or a black-ized agent of sintered compacts, 4) oxygen content of a sintered compact, 5)impurities contents other than oxygen and the sintering aid of a sintered compacts, 6) the size of the aluminum nitride particles in a sintered compact, 7) the form of the aluminum nitride particles in a sintered compact, it is because it can think that the factor which affects the transmissivity of these sintered compacts has a high possibility of having had a certain effect also to generation of the single crystal thin film which comprises as the main ingredients at least one or more materials selected from a gallium nitride, an indium nitride, and an aluminum nitride.

In this invention, although correlation is accepted as mentioned above between transmissivity of a sintered compact which comprises an aluminum nitride as the main ingredients and generation of the single crystal thin film which comprises as the main ingredients at least one or more materials selected from a gallium nitride, an indium nitride, and an aluminum nitride on the substrate which consists of this sintered compact, even if the optical transmissivity to the visible light of a sintered compact which comprises an aluminum nitride as the main ingredients, or the optical transmissivity to ultraviolet light is lower than 1% respectively, or does not penetrate light substantially, generation of the single crystal thin film which comprises as the main ingredients at least one or more materials selected from a gallium nitride, an indium nitride, and an aluminum nitride on the substrate which consists of a sintered compact which comprises an aluminum nitride as the main ingredients is possible.

For example, the transmissivity of the sintered compact which comprises an aluminum nitride as the main ingredients and contains black-ized elements, such as molybdenum, tungsten, and carbon, or unescapable metal impurities, such as iron, nickel, chromium, and manganese, or firing temperature reduction-ized agents, such as alkali metals containing lithium ctc., silicon compounds, etc., is lower than 1%, or the transmissivity is zero substantially in many cases.

Even if it is the substrate which consists of such sintered compact, the single crystal thin film which comprises as the main ingredients at least one or more materials selected from a gallium nitride, an indium nitride, and an aluminum nitride can form directly on it, and what is good crystallinity, such that the above-mentioned half width of the rocking curve of the X-ray diffraction line from the lattice plane of a Miller Index (002) is not more than 300 seconds, is also obtained.

As mentioned above, it is surmised that it is because the main ingredients in a sintered compact called aluminum nitride itself originally have strongly the characteristic which helps single crystallization of a thin film easily, in process in which an ingredient which comprises as the main ingredients at least one or more materials selected from a gallium nitride, an indium nitride, and an aluminum nitride is formed onto a substrate as a thin film via the gaseous phase or a molecular beam.

Although it is the density of a sintered compact which comprises an aluminum nitride as the main ingredients, if it is not in the condition with which an aluminum nitride, sintering aid, etc. were densely got blocked, what the single crystal thin film could not be formed for can be guessed easily.

Actually, in this invention, it is preferred that the relative density of a sintered compact which comprises an aluminum nitride as the main ingredients is not less than 95%, single crystal thin film which comprises as the main ingredients at least one or more materials selected from a gallium nitride, an indium nitride, and an aluminum nitride can be formed directly in such substrate.

Actually, in this invention, in the case of not less than 98% of the relative density of a sintered compact which comprises an aluminum nitride as the main ingredients, the thing of not more than 300 seconds as half width of the X-ray rocking curve of the lattice plane of the Miller Index (002) of the single crystal thin film which comprises as the main ingredients at least one or more materials selected from a gallium nitride, an indium nitride, and an aluminum nitride and was formed directly on the substrate which consists of this sintered compact which comprises an aluminum nitride as the main ingredients is easy to be formed.

In the thing in which the relative density of a sintered compact is not less than 99%, what is not more than 240 seconds as half width of the X-ray rocking curve of the lattice plane of the Miller Index (002) of this single crystal thin film is easy to be formed, it is more preferable.

Moreover, in the thing in which the relative density of a sintered compact is not less than 99.5%, what is not more than 200 seconds as half width of the X-ray rocking curve of the lattice plane of the Miller Index (002) of this single crystal thin film is easy to be formed, it is still more preferable.

In this invention, although the relative density of the sintered compact which comprises an aluminum nitride as the main ingredients and is produced without adding additives, such as sintering aid and a black-ized agent, is the one to the theoretical density (3.261 g/cm³) of an aluminum nitride, in the sintered compact which comprises an aluminum nitride as the main ingredients and is produced by adding additives, such as sintering aid and a black-ized agent, it is not to the theoretical density of an aluminum nitride, it was shown as the value over the density on calculation when considering that ingredients, such as sintering aids, are only being mixed with the aluminum nitride.

Therefore, it depends on sintered compact composition for the relative density of a sintered compact which comprises an aluminum nitride as the main ingredients.

Concretely speaking, in the sintered compact which comprises an aluminum nitride as the main ingredients and contains aluminum nitride (AlN) 95 weight % and yttrium oxide (Y₂O₃) 5 weight %, since the density of AlN is 3.261 g/cm³ and the density of Y₂O₃ is 5.03 g/cm³, when the complete densification of the sintered compact of this composition is attained, 3.319 g/cm³ of the density is calculated, the percentage of the density of the actually obtained sintered compact and the above-mentioned density by calculation becomes the relative density said in this invention.

If examples are furthermore shown, in the sintered compact which comprises an aluminum nitride as the main ingredients and contains aluminum nitride (AlN) 90 weight % and erbium oxide (Er₂O₃) 10 weight %, since the density of Er₂O₃ is 8.64 g/cm³, when the complete densification of the sintered compact of this composition is attained, 3.477 g/cm³ of the density is calculated, the percentage of the density of the actually obtained sintered compact and the above-mentioned density by calculation becomes relative density said in this invention.

In the sintered compact which comprises an aluminum nitride as the main ingredients and contains aluminum nitride (AlN) 99.5 weight % and calcium oxide (CaO) 0.5 weight %, since the density of CaO is 3.25 g/cm³, when the complete densification of the sintered compact is attained, 3.261 g/cm³ of the density is calculated, the percentage of the density of the actually obtained sintered compact and the above-mentioned density by this calculation becomes relative density said in this invention.

It can be guessed easily that the thing having a smaller size of the pore inside a sintered compact which comprises an aluminum nitride as the main ingredients can form an excellent single crystal thin film.

Actually, in this invention, in the case of the thing in which the pore size of a sintered compact is an average of not more than 1 μm, the thing of not more than 300 seconds as half width of the X-ray rocking curve of the lattice plane of the Miller Index (002) of the single crystal thin film which comprises as the main ingredients at least one or more materials selected from a gallium nitride, an indium nitride, and an aluminum nitride and was formed directly on the substrate which consists of this sintered compact which comprises an aluminum nitride as the main ingredients is easy to be formed.

Moreover, in the case of the thing in which the pore size is an average of not more than 0.7 μm, what is not more than 240 seconds as half width of the X-ray rocking curve of the lattice plane of the Miller Index (002) of this single crystal thin film is easy to be formed, it is more preferable.

Moreover, in the case of the thing in which the pore size is an average of not more than 0.5 μm, what is not more than 200 seconds as half width of the X-ray rocking curve of the lattice plane of the Miller Index (002) of this single crystal thin film is easy to be formed.

The following methods are effective in order to make improvement of the above-mentioned sintered compact density, and to make reduction of the inside pore of a sintered compact or to make the size of an internal pore small.

That is, (1) to use the thing whose grain size of a primary particle is submicron and whose distribution is uniform, as a raw material for sintered compact manufacture, (2) to lower the firing temperature and controls the grain growth, (3) to perform the atmospheric pressurure sintering and the hot press or HIP under the higher condition than 1 atmospheric pressure, (4) to perform holding temperature in many stages in firing, (5) to combine the decompression firing or normal pressure sintering with the firing under higher atmosphere than 1 atmospheric pressure, such as atmospheric pressure sintering, hot press, or HIP, etc.

It is also effective to carry out combining the above-mentioned method two or more.

The substrate according to this invention can use as sintering aid other than aluminum nitride which is a main ingredient what contains rare-earth oxides, for example, such as Sc₂O₃, Y₂O₃, La₂O₃, CeO₂, Pr6O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, Lu₂O₃, in addition to this, what contains rare-earth ingredients, such as Sc, Y, La, Ce, Pr, Nd, Pm, Sm, Eu, Gd, Tb, Dy, Ho, Er, Tm, Yb, and Lu, etc., in addition to this, what contains inorganic rare earth compounds, such as carbonate, cnitrate, sulfate, and chloride, containing such as Sc, Y, La, Ce, Pr, Nd, Pm, Sm, Eu, Gd, Tb, Dy, Ho, Er, Tm, Yb, Lu, etc., and various rare-earth compounds, such as organic rare earth compounds, such as acetate, oxalate, and citrate, alkaline earth metal oxides, such as BeO, MgO, CaO, SrO, and BaO, alkaline earth metal element ingredients, such as Be, Mg, Ca, Sr, and Ba, or other inorganic alkaline earth metal compounds, such as carbonate, nitrate, sulfate, and chloride, etc. containing Be, Mg, Ca, Sr, Ba, etc., various alkaline earth metal compounds, such as organoalkaline earth metal compounds, such as acetate, oxalate, and citrate, what simultaneously contains a rare-earth compound and an alkaline earth metal compound for the performing of firing temperature lowering, what contains alkali metal compounds, such as Li₂O, Li₂CO₃, LiF, LiOH, Na₂O, Na₂CO₃, NaF, NaOH, K₂O, K₂CO₃, KF, and KOH, and silicon compounds, such as SiO₂, Si₃N₄, and SiC, what contains metals, alloy, and metallic compound containing Mo, W, V, Nb, Ta, Ti, etc., and carbon in order to achieve black-ization.

What contains ingredients, such as a rare-earth ingredient, an alkaline earth metal ingredient, an alkali metal ingredient, a silicon ingredient, Mo, W, V, Nb, Ta, Ti, and carbon, can be used as the sintered compact which comprises an aluminum nitride as the main ingredients according to this invention, as mentioned above.

It can guess easily that these sintering aids, firing temperature reduction-ized agents, and black-ized agents also affect the transmissivity of a sintered compact.

Actually, in this invention, in the substrate which consists of a sintered compact which comprises an aluminum nitride as the main ingredients, the single crystal thin film which comprises as the main ingredients at least one or more materials selected from a gallium nitride, an indium nitride, and an aluminum nitride is easy to be formed directly on a substrate by using the sintered compact whose content of ingredients other than the above-mentioned aluminum nitride which is the main ingredients is a total of not more than 25 volume % by oxide conversion in the case of a rare earth element and an alkaline earth metal, a total of not more than 10 volume % by oxide conversion in the case of an alkali metal and silicon, and a total of not more than 25 volume % by element conversion in the case of the ingredient for achieving the above-mentioned black-ization.

As for the crystallinity of this single crystal thin film directly formed on the substrate at this time, the good thing, such that the half width of the rocking curve of the X-ray diffraction line from the lattice plane of a Miller Index (002) is not more than 300 seconds, is easy to be obtained.

The single crystal thin film which comprises as the main ingredients at least one or more materials selected from a gallium nitride, an indium nitride, and an aluminum nitride is easy to be formed directly on the substrate by using as a substrate the sintered compact which comprises an aluminum nitride as the main ingredients and contains an alkaline metal ingredient and a silicon ingredient a total of not more than 5 volume % by oxide conversion.

As for the crystallinity of this single crystal thin film directly formed on the substrate at this time, the good thing, such that the half width of the rocking curve of the X-ray diffraction line from the lattice plane of a Miller Index (002) is not more than 240 seconds, is easy to be obtained.

An alkali metal ingredient and a silicon ingredient may be respectively contained alone, or an alkaline metal ingredient and a silicon ingredient may be contained simultaneously.

The above-mentioned sintering aids, the firing temperature reduction-ized agents, and the black-ized agents tend to produce the different compound from an aluminum nitride and different crystal phase inside a sintered compact.

Since the crystal structure of the compound or a crystal phase generated by the above-mentioned sintering aids, the firing temperature reduction-ized agents, and the black-ized agents differs from wurtzite types, such as a gallium nitride, an indium nitride, and an aluminum nitride, on the substrate in which the compound and the crystal phase generated by the above-mentioned sintering aids, the firing temperature reduction-ized agents, and the black-ized agents exist so much, it is guessed that the crystal nuclear growth direction tends to become irregular and that the single crystal thin film which comprises as the main ingredients at least one or more materials selected from a gallium nitride, an indium nitride, and an aluminum nitride and which has good crystallinity is hard to be obtained.

In this invention, the content of a rare earth element and an alkaline earth metal contained in the sintered compact which constitutes the above-mentioned substrate and comprises an aluminum nitride as the main ingredients is what was asked for by recalculating to volume percentage (volume %) from the density of these oxides after they were converted into a rare earth element oxide and an alkaline-earth-metals oxide after asking for the rare earth and alkaline-earth metal which are contained by weight percentage (weight %) as a rare earth element and an alkaline-earth-metals element.

The rare-earth oxides used for conversion are Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, and the alkaline earth metal oxides are BeO, MgO, CaO, SrO, and BaO.

The content of an alkaline metal and a silicon contained in the sintered compact which constitutes a substrate and comprises an aluminum nitride as the main ingredients is what was asked for by recalculating to volume percentage (volume %) from the density of these oxides after they were converted into an alkaline metal oxide and a silicon oxide after asking for the alkaline metal and silicon which are contained by weight percentage (weight %) as an alkaline metal and a silicon.

The alkali metal oxides used for conversion are Li₂O, Na₂O, K₂O, Rb₂O, and Cs₂O, the silicon oxide is SiO₂ (density: 2.65 g/cm³).

The content of the compound containing the metal, alloy and metallic compound containing Mo, W, V, Nb, Ta, Ti, etc., and carbon, etc. which are contained in the sintered compact which comprises an aluminum nitride as the main ingredients and constitutes a substrate means followng, namely, it calculates with weight percentage (weight %) by using the content of Mo, W, V, Nb, Ta, Ti, and carbon each ingredient contained as an element, and further, from the density of these elements, it recalculates to volume percentage (volume %), and it is asked.

Each element ingredient other than the aluminum nitride contained in a substrate is converted into an oxide, and it is calculated as the above-mentioned volume % (volume percentage) from the density and the weight percent of this oxide.

For example, although it does not mean the volume percent of the reactant which arises actually by the mutual reaction of each element ingredient other than the aluminum nitride contained in the above-mentioned substrate or by the reaction with unescapable mixing ingredients, such as oxygen and a transition metal etc., it can be the scale which measures the densification degree of a sintered compact.

Concretely speaking, in the sintered compact which comprises an aluminum nitride as the main ingredients and contains aluminum nitride (AlN) 95 weight % and yttrium oxide (Y₂O₃) 5 weight %, since the density of AlN is 3.261 g/cm³ and the density of Y₂0₃ is 5.03 g/cm³, it is calculated that the content of a rare-earth compound is 3.30 volume %. In the sintered compact which comprises an aluminum nitride as the main ingredients and contains aluminum nitride (AlN) 90 weight % and erbium oxide (Er₂O₃) 10 weight %, since the density of Er₂O₃ is 8.64 g/cm³, it is calculated that the content of a rare-earth compound is 4.02 volume %.

In the sintered compact which comprises an aluminum nitride as the main ingredients and contains aluminum nitride (AlN) 99.5 weight % and calcium carbonate (CaCO₃) 0.5 weight % by calcium oxide (CaO) conversion, since the density of CaO is 3.25 g/cm³, it is calculated that the content of an alkaline earth metal compound is 0.50 volume %.

The substrate by this invention contains not only the above-mentioned ingredient for achieving black-ization, the ingredient for attaining reduction-ization of firing temperature, and the ingredient as sintering aid, but the unescapable impurities ingredient of the transition metals which it is contained in the raw material for sintered compact manufacture, or are easy to mix from a manufacturing process, other than aluminum nitride which is a main ingredient.

Such unescapable impurities contain ingredients, such as transition metal other than a rare earth element and Mo, W, V, Nb and Ta, and Ti, for example, iron, nickel, chromium, manganese, zirconium, hafnium, cobalt, copper, and zinc.

In this invention, “Containing the unescapable impurities ingredient of a transition metal” means that at least one or more ingredients, such as above-mentioned iron, nickel, chromium, manganese, zirconium, hafnium, cobalt, copper, and zinc, are included.

Such as the above-mentioned transition metal, the amount of mixing of the unescapable impurities ingredient contained in the substrate which consists of a sintered compact which comprises an aluminum nitride as the main ingredients is usually not more than 1 weight % in many cases, it is not more than 0.5 weight %, or not more than 0.2 weight %, and preferably not more than 0.05 weight %.

Of course, although the fewest possible ones of mixing of such unescapable impurities are preferred, even if it is the sintered compact which comprises an aluminum nitride as the main ingredients and contains comparatively many transition-metals ingredients, such as the above-mentioned iron, nickel, chromium, manganese, zirconium, hafnium, cobalt, copper, and zinc, in this invention, the single crystal thin film which comprises as the main ingredients at least one or more materials selected from a gallium nitride, an indium nitride, and an aluminum nitride can be formed directly on a substrate.

As for the content of transition-metals ingredients, such as the above-mentioned iron in the sintered compact which comprises an aluminum nitride as the main ingredients, nickel, chromium, manganese, zirconium, hafnium, cobalt, copper, and zinc, it is preferably that it is not more than 30 weight % by element conversion, the single crystal thin film which comprises as the main ingredients at least one or more materials selected from a gallium nitride, an indium nitride, and an aluminum nitride can be formed directly on a substrate, as for the crystallinity of this single crystal thin film formed on the substrate which consists of a sintered compact which comprises an aluminum nitride as the main ingredients at this time, the good thing, such that the half width of the rocking curve of the X-ray diffraction line from the lattice plane of a Miller Index (002) is not more than 300 seconds, is easy to be obtained at this time.

When the substrate whose content of the ingredient containing unescapable impurities is not more than 20 weight % by element conversion is used, as for the crystallinity of this single crystal thin film formed directly on the substrate, since the good thing, such that the half width of the rocking curve of the X-ray diffraction line from the lattice plane of a Miller Index (002) is not more than 240 seconds, is easy to be obtained, as a substrate it is more desirable, if it is not more than 10 weight %, as for the crystallinity of this single crystal thin film formed directly on the substrate, since the good thing, such that the half width of the rocking curve of the X-ray diffraction line from the lattice plane of a Miller Index (002) is not more than 200 seconds is easy to be obtained, it is more desirable.

When manufacturing the sintered compact which comprises an aluminum nitride as the main ingredients, mixing of unescapable impurities can be decreased with the device of achieving high purity-ization of the material used for the portion where ceramics contact using a high purity raw material in manufacturing processes, such as the manufacture of a green sheet and a granule for powder pressing, or the firing.

The substrate by this invention contains not only the above-mentioned ingredient as sintering aids, ingredient for achieving black-ization, ingredient for attaining reduction-ization of firing temperature, and unescapable metal impurities ingredients, but also oxygen which is contained in the raw material for sintered compact manufacture and is mixed furthermore from a manufacturing process, other than aluminum nitride which is a main ingredient.

Oxygen is usually contained about 0.01 to 5.0 weight % in the raw material for sintered compact manufacture, although it vaporizes in part during firing, it is almost incorporated into a sintered compact as it is in many case, and ALON (aluminum oxynitride: the compound between AlN and Al₂O₃) of a spinel type crystal structure is generated in the sintered compact manufactured without using sintering aids etc. in many case.

This ALON shows the diffraction line usually shown in the JCPDS file number 36-50.

Oxygen is contained by adding Al₂O₃ positively so that ALON may be generated in a sintered compact again.

Furthermore, the part of these is also contained when sintering aids and a black-ized agents are the compounds containing oxygen, such as an oxide and a compound oxide.

If there are more amounts of oxygen in a sintered compact than 10 weight %, generation of compounds, such as ALON, or between sintering aid and oxygen, or between black-ized agent and oxygen, between a firing temperature reduction-ized agent and oxygen, etc., will increase inside a sintered compact, and it will be easy to bring about the lowering of the crystallinity of a single crystal thin film.

Although the amount of generation of ALON in the inside of a sintered compact is controllable by the amount of oxygen and the amount of sintering aids, such as a rare-earth compound and an alkaline earth metal compound, when not using sintering aids, it is dependent only on the amount of oxygen in a sintered compact.

Although the crystal structure of above ALON differs from wurtzite types, such as an a gallium nitride, an indium nitride, and an aluminum nitride, if the amount of ALON(s) is not more than 12% in the sintered compact which comprises an aluminum nitride as the main ingredients, as for the crystallinity of the single crystal thin film which comprises as the main ingredients at least one or more materials selected from a gallium nitride, an indium nitride, and an aluminum nitride and was formed directly on the substrate which consists of this sintered compact which comprises an aluminum nitride as the main ingredients, since what is not more than 240 seconds as half width of the rocking curve of the X-ray diffraction line from the lattice plane of the Miller Index (002) of this single crystal thin film is easy to be formed and improvement of crystallinity is shown, it is desirable.

If the sintered compact whose quantity of ALON is not more than 7% is used as a substrate, since what is not more than 200 seconds in the above-mentioned half width of the rocking curve of the X-ray diffraction is easy to be formed and more improvement of crystallinity is shown, it is desirable.

he content of ALON is what calculated the ratio of the diffraction line intensity from the Miller Index (311) lattice plane of ALON and the diffraction line intensity from the Miller Index (100) lattice plane of AlN by percentage according to X-ray diffraction on the surface of a substrate.

In the inside of a sintered compact, what is the amount of ALON not more than 12% is easy to be formed by what is the amount of oxygen not more than 5.0 weight % in the sintered compact which is fired only with aluminum nitride raw material powder or only with the mixed powder of this raw material powder and Al₂O₃ without using additives, such as sintering aid.

What is the amount of ALON not more than 7% is easy to be formed by what is the amount of oxygen not more than 3.0 weight % in the sintered compact which is fired only with aluminum nitride raw material powder or only with the mixed powder of this raw material powder and Al₂O₃ without using additives, such as sintering aid.

Moreover, if the substrate whose amount of ALON in a sintered compact is not more than 20% is used, the thing of not more than 300 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride is easy to be formed on a substrate.

What is the amount of ALON not more than 20% is easy to be formed by what is the amount of oxygen not more than 10.0 weight % in the sintered compact which is fired only with aluminum nitride raw material powder or only with the mixed powder of this raw material powder and Al₂O₃ without using additives, such as sintering aid.

On the substrate in which ALON more than 20% is generating in a sintered compact, it is hard coming to form the single crystal thin film which comprises as the main ingredients at least one or more materials selected from a gallium nitride, an indium nitride, and an aluminum nitride and has good crystallinity not more than 300 seconds as half width of the rocking curve of the X-ray diffraction line from the lattice plane of a Miller Index (002).

It is conjectured that it will be because the power of trying to go in the direction of C axis in which the crystal growth of this single crystal thin film has originally is prevented and it becomes easy to become an irregular direction by increase of ALON crystal different from a wurtzite type.

Although the ALON content in the sintered compact which comprises an aluminum nitride as the main ingredients is calculated according to X-ray diffraction as mentioned above by the percentage of the ratio of the diffraction line intensity from the Miller Index (311) lattice plane of ALON and the diffraction line intensity from the Miller Index (100) lattice plane of AlN, density 3.837 g/cm³ of ALON indicated by the oxygen content contained in this sintered compact and the above-mentioned JCPDS file number 36-50 is compared, and it can be regarded as a volume fraction in approximation.

When compounds other than AlN and ALON are generating in the sintered compact which comprises an aluminum nitride as the main ingredients, the content of ALON is what calculated with percentage by asking for the ratio between the strongest line of ALON and what totaled the strongest line of this compound and the strongest line of AlN and ALON, according to X-ray diffraction.

In this invention, although the content of oxygen and the content of transition metal other than Mo, W, V, Nb, Ta, and Ti such as iron, nickel, chromium, manganese, zirconium, hafnium, cobalt, copper, and zinc is shown with the weight percent (weight %) by each element conversion, it can perform easily re-showing these ingredients with volume percentage by the above-mentioned method.

When recalculating the content of iron, nickel, chromium, manganese, zirconium, hafnium, cobalt, copper, and zinc, etc. to volume percentage, it asks with weight percent (weight %) by using the content of each ingredient, such as these iron, nickel, chromium, manganese, zirconium, hafnium, cobalt, copper, and zinc, as an element, and further, from the density of these elements, it recalculates to volume percentage (volume %), and it can be asked.

When recalculating the content of oxygen with volume percentage, after calculating this oxygen content with weight percent as an element using oxygen, nitrogen analysis apparatus of commercial item, etc., it reconverts into Al₂O₃, namely, can ask as volume percentage of Al₂O₃.

As for the reason reconverted into Al₂O₃, this oxygen reacts in the sintered compact which comprises an aluminum nitride as the main ingredients with an aluminum ingredient, or an aluminum nitride, or sintering aids such as a rare earth element and an alkaline earth metal etc., it exists in many cases as Al₂O₃ or ALON or a complex oxide with a rare earth element or an alkaline earth metal, since this ALON is the compound of AlN and Al₂O₃ and this complex oxide with a rare earth element or an alkaline earth metal is a compound between the oxide of a rare earth element or the oxide of an alkaline earth metal and Al₂O₃, it is because the oxygen ingredient contained after all can be regarded as Al₂O₃ in many cases.

The density of Al₂O₃ is 3.987 g/cm³, and can be easily recalculated based on this.

For example, in the sintered compact which comprises an aluminum nitride as the main ingredients and contains oxygen 5 weight %, since the density of AlN is 3.261 g/cm³, it is calculated as this content of oxygen being 8.86 volume %.

In the sintered compact which contains iron 1 weight % by element conversion and comprises an aluminum nitride as the main ingredients, since the iron density is 7.86 g/cm³, it is calculated that the iron content is 0.417 volume % by element conversion.

When recalculating the content of ALON to volume percentage in this invention, after calculating the content of ALON according to X-ray diffraction, when contained except ALON and AlN, in the density pan of density, it can carry out by asking for 3.837 g/cm³ of ALON density and AlN density, and by asking for the content and density of the ingredient when contained except ALON and AlN.

It can be considered that the content of ALON contained in the sintered compact which comprises an aluminum nitride as the main ingredients by the creation result X-ray diffraction of a working curve is a weight fraction in approximation.

For example, in the sintered compact which comprises an aluminum nitride as the main ingredients and contains ALON 10%, it is reckonable so that the content of ALON is 8.63 volume %.

In this invention, in the substrate which consists of a sintered compact which comprises an aluminum nitride as the main ingredients, what sintered the aluminum nitride particle in a sintered compact in the same condition as the size of the particle of raw material powder without making it grow up with about an average of 0.5 μm can be used.

On the other hand, in the substrate according to this invention which consists of a sintered compact which comprises an aluminum nitride as the main ingredients, if the size of an aluminum nitride particle contained in the inside of a sintered compact increases, the crystallinity of the thin film which comprises as the main ingredients at least one or more materials selected from the a gallium nitride, an indium nitride, and an aluminum nitride and is formed on this substrate will tend to improve.

When the quality of the thin film is estimated by the crystallinity of this single crystal thin film after the thin film which comprises as the main ingredients at least one or more materials selected from a gallium nitride, an indium nitride, and an aluminum nitride is formed as single crystal, if the size of the aluminum nitride particle contained in the inside of a sintered compact which comprises an aluminum nitride as the main ingredients is an average of not less than 1 μm, what is not more than 300 seconds as half width of the rocking curve of the X-ray diffraction line from the lattice plane of the Miller Index (002) of a single crystal thin film directly formed on the substrate which consists of this sintered compact is easy to be formed.

In the sintered compact whose size of an aluminum nitride particle is an average of not less than 5 μm, what is good crystallinity, such that the half width of the rocking curve of the X-ray diffraction line from the lattice plane of a Miller Index (002) of a single crystal thin film which comprises as the main ingredients at least one or more materials selected from a gallium nitride, an indium nitride, and an aluminum nitride and is formed on a substrate is not more than 240 seconds, is easy to be obtained.

In the sintered compact whose size of an aluminum nitride particle is an average of not less than 8 μm, what is better crystallinity, such that the half width of the rocking curve of the X-ray diffraction line from the lattice plane of a Miller Index (002) of the above-mentioned single crystal thin film is not more than 200 seconds, is easy to be obtained.

In the sintered compact whose size of an aluminum nitride particle is an average of not less than 15 μm, what is still better crystallinity, such that the half width of the rocking curve of the X-ray diffraction line from the lattice plane of a Miller Index (002) of the above-mentioned single crystal thin film is not more than 150 seconds, is easy to be obtained.

In the sintered compact whose size of an aluminum nitride particle is an average of not less than 25 μm, what is still better crystallinity, such that the half width of the rocking curve of the X-ray diffraction line from the lattice plane of a Miller Index (002) of the above-mentioned single crystal thin film is not more than 130 seconds, is easy to be obtained.

if the size of the aluminum nitride particle inside a sintered compact becomes large, because the area of the grain boundary of an aluminum nitride crystal grain will decrease and the effect of a grain boundary will reduce, the property of the aluminum nitride crystal grain itself will become easy to be revealed, it is surmised that it will be easy to make the nuclear growth direction of the single crystal thin film which comprises as the main ingredients at least one or more materials selected from a gallium nitride, an indium nitride, and an aluminum nitride more regular.

Even if the effect of enlarging the above aluminum nitride particles is seen also by the substrate which consists of a sintered compact which usually uses the aluminum nitride of what kind of composition as the main ingredients.

The example of such sintered compact which comprises an aluminum nitride as the main ingredients is as follows, namely, what contains the above mentioned oxygen, or ingredients used as sintering aid, such as a rare-earth compound and an alkaline earth metal compound, or what contains the ingredients used as a firing temperature reduction-ized agent, such as an alkali metal and silicon, or what contains the metal ingredients used as a black-ized agent, such as Mo, W, V, Nb, Ta, Ti, etc., or carbon, or what contains the unescapable metal ingredients other than Mo, W, V, Nb, Ta, and Ti, etc., furthermore, what contains the ALON etc. as a crystal phase.

The sintered compact which is manufactured without adding sintering aids to raw material powder as an example of such sintered compact which comprises an aluminum nitride as the main ingredients, and does not contain sintering aids, such as a rare-earth compound or an alkaline earth metal compound, substantially is also contained.

In the substrate which consists of a sintered compact which comprises an aluminum nitride as the main ingredients illustrated above, the quality of the single crystal thin film which comprises as the main ingredients at least one or more materials selected from a gallium nitride, an indium nitride, and an aluminum nitride and is formed on this substrate by increasing the size of an aluminum nitride particle becomes easy to improve.

Although the effect of making the size of the aluminum nitride particle in a sintered compact which comprises an aluminum nitride as the main ingredients increase-izing is described also later, if the sintered compact which comprises an aluminum nitride as the main ingredients and which was made to increase the size of an aluminum nitride particle and further raised AlN purity is used as a substrate for thin film formation, the quality of the single crystal thin film which comprises as the main ingredients at least one or more materials selected from a gallium nitride, an indium nitride, and an aluminum nitride and is formed on these substrates becomes easy to improve.

Usually, the above-mentioned effect of enlarging an aluminum nitride particle is seen in the substrate which consists of a sintered compact which comprises an aluminum nitride as the main ingredients and has any composition, the degree of an effect tends to decrease as the content of AlN in a sintered compact decreases.

If the content of AlN in the substrate according to this invention which consists of the sintered compact which comprises an aluminum nitride as the main ingredients is more than 50 volume %, it can form the single crystal thin film which comprises as the main ingredients at least one or more materials selected from a gallium nitride, an indium nitride, and an aluminum nitride by using this substrate.

In the sintered compact which comprises an aluminum nitride as the main ingredients and whose content of AlN is not less than 50 volume %, the thing of not more than 3600 seconds as half width of the rocking curve of the X-ray diffraction line from the lattice plane of the Miller Index (002) of the single crystal thin film which is formed on this sintered compact and comprises as the main ingredients at least one or more materials selected from a gallium nitride, an indium nitride, and an aluminum nitride is easy to be obtained.

In order to make the above effect of enlarging the aluminum nitride particles easy to generate, as for the content of AlN in the substrate which consists of a sintered compact which comprises an aluminum nitride as the main ingredients, it is desirable that it is not less than 80 volume %.

In the thing whose content of AlN of the sintered compact which comprises an aluminum nitride as the main ingredients is not less than 80 volume %, the thing of not more than 300 seconds as half width of the rocking curve of the X-ray diffraction line from the lattice plane of the Miller Index (002) of the single crystal thin film which is formed on this sintered compact and comprises as the main ingredients at least one or more materials selected from a gallium nitride, an indium nitride, and an aluminum nitride is easy to be obtained.

In addition, the size of the crystal grain contained inside a sintered compact which comprises an aluminum nitride as the main ingredients is average magnitude, not only what is in the state where the crystal grain contained has gathered in the nearly equal size but also what has the irregular size of a crystal grain, or what contains the crystal grain of which form is distorted and the crystal grain of form where one side is small and one side is large, such as a needle or the shape of a board, or what contains the crystal grains, such as needlelike or the shape of a board, in which one side is several μm and other one side grew up into about ten or more μm greatly, for example, such as a poly type AlN particle etc., can be used satisfactorily in this invention.

In order to make the size of the aluminum nitride particle in a sintered compact which comprises an aluminum nitride as the main ingredients increase, it is effective usually to raise firing temperature or to lengthen firing time.

In order to control the size of an aluminum nitride particle, although it is easy to be dependent also on the origin and the grain size of raw material powder of an aluminum nitride, or the composition of the compact or sintered compact, according to this invention, by firing for comparatively long time not less than 3 hours at the temperature not less than 1750 degrees C., the sintered compact which comprises an aluminum nitride as the main ingredients and has aluminum nitride particle of an average of not less than 5 μm is easy to be obtained.

In order to obtain the sintered compact of the aluminum nitride particle which has an average of not less than 8 μm, it is preferred to perform the firing at the temperature not less than 1750 degrees C. for not less than 10 hours, and at the temperature not less than 1900 degrees C. for not less than 3 hours.

In order to obtain the sintered compact of the aluminum nitride particle which has an average of not less than 15 μm, it is preferred to perform the firing at the temperature not less than 1900 degrees C. for not less than 6 hours, and at the temperature not less than 2050 degrees C. for not less than 3 hours.

In order to obtain the sintered compact of the aluminum nitride particle which has an average of not less than 25 μm, it is preferred to perform the firing at the temperature not less than 2050 degrees C. for not less than 4 hours, and at the temperature not less than 2100 degrees C. for not less than 3 hours.

In such firing, in order to obtain the sintered compact which comprises an aluminum nitride as the main ingredients and is the state, such that only the size of a particle is increasing and the evaporation and removemebt of an ingredient, such as oxygen, or the ingredients used as sintering aid, such as a rare-earth compound or an alkaline earth metal compound, etc., or the ingredients used as a firing temperature reduction-ized agent, such as an alkali metal and silicon, etc. or the meta ingredients used as a black-ized agent, such as Mo, W, V, Nb, Ta, Ti, etc., or carbon, or the unescapable metal ingredients other than Mo, W, V, Nb, Ta, and Ti, etc., are controlled and ALON etc. is contained further as a crystal phase contained, it is preferred to use non-oxidizing atmospheres, such as nitrogen and argon, whose reduction nature ingredients are comparatively little as described above.

On the other hand, in order to obtain the sintered compact which comprises an aluminum nitride as the main ingredients and whose size of an aluminum nitride particle was increased and whose AlN purity improved, it is preferred to fire in the non-oxidizing atmosphere containing reduction nature ingredients, such as hydrogen, carbon monoxide, carbon, and hydrocarbon.

In the substrate according to this invention which consists of the sintered compact which comprises an aluminum nitride as the main ingredients, if the form of an aluminum nitride particle contained in the inside of a sintered compact is what is a polygonal and that whose overlap in each surface and ridgeline, or at a polygonal vertex is tight than the round thing in which the edge of a particle was smoothed out, the optical transmissivity of a sintered compact is raised to not less than 1%, as for the crystallinity of the single crystal thin film which comprises as the main ingredients at least one or more materials selected from a gallium nitride, an indium nitride, and an aluminum nitride and is formed on a substrate, since the good thing, such that the half width of the rocking curve of the X-ray diffraction line from the lattice plane of a Miller Index (002) is not more than 300 seconds, is easy to be obtained, it is desirable as a substrate.

That is, if the form of an aluminum nitride particle is a round thing whose edge was smoothed out, since the sintered compact particles cannot unite together without a space in the inside of a sintered compact, the grain boundary phase which consists of ingredients other than an aluminum nitride tends to intervene, the transmissivity of a sintered compact lowers according to these grain boundary phase, furthermore, it is surmised that it will make the nuclear growth direction of the single crystal thin film which comprises as the main ingredients at least one or more materials selected from a gallium nitride, an indium nitride, and an aluminum nitride and which is beginning to grow irregular.

The roundish particles of a sintered compact are seen when the above-mentioned sintering aids and firing temperature reduction-ized agents are usually contained superfluously.

That is, since the superfluous liquid phase is generated by the superfluous sintering aid in firing, and a sintered compact particle grows in the liquid phase it is easy to be roundish.

In this invention, that a sintered compact particle becomes easy to be roundish means being easy to be generated when sintering aids, such as the above-mentioned rare-earth compound and an alkaline earth metal element compound, and firing temperature reduction-ized agents, such as an alkali metal compound, and a silicon compound, etc., are contained more than the range shown above.

In the raw material powder for manufacturing the sintered compact which comprises an aluminum nitride as the main ingredients and is used as the above-mentioned substrate for thin film formation, oxygen is usually contained about 0.01 weight %-5.0 weight % in addition to an AlN ingredient.

As for the content of a rare earth element contained in the sintered compact which comprises an aluminum nitride as the main ingredients in this invention, it is preferred to use what is not more than 50 volume % by oxide conversion as mentioned above.

As for the content of a rare earth element contained in the sintered compact which comprises an aluminum nitride as the main ingredients, it is still more preferred that it is not more than 25 volume % by oxide conversion.

The desirable content of the above-mentioned rare earth element is not more than 12.0 volume % by oxide conversion.

More desirable content is not more than 7.0 volume % by oxide conversion.

Since the above-mentioned rare earth element carrys out the action which traps oxygen contained in a raw material, makes it deposit as a grain boundary phase, and makes the aluminum nitride crystal grain in a sintered compact into high purity, promoting densification of an aluminum nitride powder compact, they raise the thermal conductivity of the substrate obtained on the whole.

Therefore, in the sintered compact which comprises an aluminum nitride as the main ingredients and was obtained after firing, an existence form of a rare earth element is a complex oxide with aluminum, or the oxide of only a rare earth element, in many case.

The existence as a complex oxide can be easily identified according to X-ray diffraction.

This complex oxide has three kinds of crystal forms, such as 3Ln₂O₃.5Al₂O₃ of a garnet type crystal structure, Ln₂O₃.Al₂O₃ of a perovskite type crystal structure, and monoclinic system crystal structure 2Ln₂O₃.Al₂O₃, when a rare earth element is expressed with Ln.

1 of these complex oxides or 2 or more are included simultaneously.

The above-mentioned complex oxide mainly exists as a grain boundary phase between aluminum nitride particles in the inside of a sintered compact.

The substrate of this invention contains that whose complex oxides were formed.

These complex oxides have a different crystal structure from the wurtzite type of an aluminum nitride particle.

According to this invention, in the substrate for thin film formation and thin film substrate, as for the single crystal thin film which comprises as the main ingredients at least one or more materials selected from a gallium nitride, an indium nitride, and an aluminum nitride and is formed directly on the sintered compact which comprises an aluminum nitride as the main ingredients and whose content of a rare earth element is not more than 50 volume % by oxide conversion, what is not more than 3600 seconds as half width of the rocking curve of the X-ray diffraction line from the lattice plane of the Miller Index (002) of this single crystal thin film is easy to be obtained.

Moreover, according to the case, as for the single crystal thin film which comprises as the main ingredients at least one or more materials selected from a gallium nitride, an indium nitride, and an aluminum nitride and is formed directly on the sintered compact which comprises an aluminum nitride as the main ingredients and whose content of a rare earth element is not more than 50 volume % by oxide conversion, what is not more than 300 seconds as half width of the rocking curve of the X-ray diffraction line from the lattice plane of the Miller Index (002) of this single crystal thin film may be obtained.

According to this invention, in the substrate for thin film formation and thin film substrate, as for the single crystal thin film which comprises as the main ingredients at least one or more materials selected from a gallium nitride, an indium nitride, and an aluminum nitride and is formed directly on the sintered compact which comprises an aluminum nitride as the main ingredients and whose content of a rare earth element is not more than 25 volume % by oxide conversion, what is excellent in crystallinity, such that the half width of the rocking curve of the X-ray diffraction line from the lattice plane of the Miller Index (002) of this single crystal thin film is not more than 300 seconds, is easy to be obtained.

When the content of a rare earth element of the sintered compact which comprises an aluminum nitride as the main ingredients is more than 25 volume % by oxide conversion as mentioned ave, although the thing of not more than 300 seconds as half width of the rocking curve of the X-ray diffraction line from the lattice plane of the Miller Index (002) of the formed single crystal thin film which comprises as the main ingredients at least one or more materials selected from a gallium nitride, an indium nitride, and an aluminum nitride becomes hard to be obtained according to a case, since many complex oxides from which a crystal structure differs probably generated, the controlling force which makes the nuclear growth direction of a single crystal thin film regular exceeds limit, and it is surmised whether, as a result, nuclear growth will become irregular.

In this invention, in the substrate which contains a rare earth element, originally the form of the aluminum nitride particle in a sintered compact tends to become not a round thing whose edge was smoothed out but a dense thing which is a polygon and has not a space at the surface of particles, the ridgeline, or the polygonal vertex by accompanying a overlap.

And, by using the sintered compact which comprises an aluminum nitride as the main ingredients and whose content of a rare earth element is not more than 12.0 volume % by oxide conversion, as for the single crystal thin film which comprises as the main ingredients at least one or more materials selected from a gallium nitride, an indium nitride, and an aluminum nitride and formed directly on this sintered compact which comprises an aluminum nitride as the main ingredients, what is more excellent in crystallinity, such that the half width of the rocking curve of the X-ray diffraction line from the lattice plane of the Miller Index (002) of this single crystal thin film is not more than 240 seconds, is easy to be obtained.

In the sintered compact which comprises an aluminum nitride as the main ingredients and whose content of a rare earth element is not more than 7.0 volume % by oxide conversion, as for the single crystal thin film which comprises as the main ingredients at least one or more materials selected from a gallium nitride, an indium nitride, and an aluminum nitride and is formed on this sintered compact which comprises an aluminum nitride as the main ingredients, what is still more excellent in crystallinity, such that the half width of the rocking curve of the X-ray diffraction line from the lattice plane of the Miller Index (002) of this single crystal thin film is not more than 200 seconds, is easy to be obtained.

As for this improvement of crystallinity in the single crystal thin film which comprises as the main ingredients at least one or more materials selected from a gallium nitride, an indium nitride, and an aluminum nitride, it is probably surmised by accompanying reduction of the amount of generation of 3Ln₂O₃.5Al₂O₃ of the above-mentioned garnet type crystal structure (for example, 3Y₂O₃.5Al₂O₃, 3Dy₂O₃.5Al₂O₃, 3Ho₂O₃.5Al₂O₃, 3Er₂O₃.5Al₂O₃, 3Yb₂O₃.5Al₂O₃, etc.), Ln₂O₄.Al₂O₃ (for example, YAlO₃, LaAlO₃, PrAlO₃, NdAlO₃, SmAlO₃, EuAlO₃, GdAlO₃, DyAlO₃, HoAlO₃, ErAlO₃, YbAlO₃, etc.) of a perovskite type crystal structure, and Monoclinic system crystal structure 2Ln₂O₃.Al₂O₃ (for example, 2Y₂O₃.Al₂O₃, 2Sm₂O₃.Al₂O₃, 2Eu₂O₃.Al₂O₃, 2Gd₂O₃.Al₂O₃, 2Dy₂O₃.Al₂O₃, 2Ho₂O₃.Al₂O₃, 2Er₂O₃.Al₂O₃, 2Yb₂O₃.Al₂O₃) which exists mainly as a grain boundary phase.

In the substrate of this invention, it is preferred that the content of an alkaline earth metal contained in the above-mentioned sintered compact which comprises an aluminum nitride as the main ingredients is also below 25 volume % by oxide conversion as above-mentioned.

Desirable content is below 5.0 volume % by oxide conversion.

More desirable content is below 3.0 volume % by oxide conversion.

Since an alkaline earth metal carries out the trap of the oxygen contained in a raw material and carries out the action to which it is made to deposit as a grain boundary phase, and high purification of the AlN crystal grain in an aluminum nitride ceramic is carried out, promoting the densification of an aluminum nitride powder compact, it raises the thermal conductivity of the substrate obtained as a whole.

Therefore, in aluminum nitride substrate obtained after firing an alkaline earth element's existence form is a complex oxide with aluminum, or an independent alkaline earth metal oxide in many cases.

The existence as a complex oxide can be easily identified according to X-ray diffraction.

This complex oxide has crystal forms, such as 3AeO.Al₂O₃, Ae.Al₂O₃, Ae.2Al₂O₃, and Ae.6Al₂O₃, when an alkaline earth metal element is expressed with Ae.

One of these complex oxides or two or more are included simultaneously.

The complex oxide containing the above-mentioned alkaline earth metal element mainly exists as a grain boundary phase between aluminum nitride particles in the inside of a sintered compact.

The substrate of this invention contains that whose complex oxides were formed.

These complex oxides have a different crystal structure from the wurtzite type of an aluminum nitride particle.

In the substrate of this invention, in the thing whose content of an alkaline earth metal in a sintered compact is not more than 25 volume % by oxide conversion, the thing excellent in crystallinity not more than 300 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride is easy to be obtained.

In the substrate of this invention, when there is more alkaline earth metal than 25 volume % by oxide conversion, as shown above, though it has the tendency in which the thing excellent in crystallinity not more than 300 seconds as half width of the rocking curve of the X-ray diffraction line from the lattice plane of the Miller Index (002) of the formed single crystal thin film which comprises as the main ingredients at least one or more materials selected from a gallium nitride, an indium nitride, and an aluminum nitride becomes hard to be obtained, since such many complex oxides whose crystal structures differ probably generated, the controlling force which makes the nuclear growth direction of a single crystal thin film regular exceeds limit, and it is surmised whether, as a result, nuclear growth will become irregular.

In the substrate which consists of a sintered compact in this invention which comprises an aluminum nitride as the main ingredients, as for the thing whose content of an alkaline earth metal has not more than 5.0 volume % by oxide conversion, that whose form of the aluminum nitride particle in a sintered compact is a polygon is mostly, and it is easy to become into that whose overlap in each surface and ridgeline, or at a polygonal vertex is tight.

Using the substrate containing an alkaline earth metal in this composition range, the thing more excellent in crystallinity is easy to be obtained, that is, the half width of the rocking curve of the X-ray diffraction line from the lattice plane of a Miller Index (002) of the single crystal thin film which comprises as the main ingredients at least one or more materials selected from a gallium nitride, an indium nitride, and an aluminum nitride is not more than 240 seconds.

In the substrate whose content of an alkaline earth metal is not more than 3.0 volume % by oxide conversion, the thing still more excellent in crystallinity, such that the half width of the rocking curve of the X-ray diffraction line from the lattice plane of a Miller Index (002) of the single crystal thin film which comprises as the main ingredients at least one or more materials selected from a gallium nitride, an indium nitride, and an aluminum nitride is not more than 200 seconds, is easy to be obtained.

As the cause of this improvement of crystallinity in the single crystal thin film which comprises as the main ingredients at least one or more materials selected from a gallium nitride, an indium nitride, and an aluminum nitride, it is surmised that it is because it follows on reduction of the amount of generation of a complex oxide which has a different crystal structure from wurtzite types, such as above-mentioned 3AeO.Al₂O₃, Ae.Al₂O₃, Ae.2Al₂O₃, and Ae.6Al₂O₃, which probably exist mainly as a grain boundary phase.

As for the content of at least one or more ingredients selected from Mo, W, V, Nb, Ta, Ti, and carbon which are contained in the sintered compact which comprises an aluminum nitride as the main ingredients in this invention, it is preferred that it is below 25 volume % by element conversion as mentioned above.

The single crystal thin film which comprises as the main ingredients at least one or more materials selected from a gallium nitride, an indium nitride, and an aluminum nitride is easy to be formed directly on the substrate which consists of a sintered compact which comprises an aluminum nitride as the main ingredients and has such composition, and the good thing, such that the half width of the rocking curve of the X-ray diffraction line from the lattice plane of a Miller Index (002) is not more than 300 seconds as the crystallinity of this single crystal thin film, is easy to be obtained.

Moreover, in the substrate of a sintered compact which comprises an aluminum nitride as the main ingredients and whose content of at least one or more ingredients selected from Mo, W, V, Nb, Ta, Ti, and carbon is not more than 10 volume % by element conversion, the better thing, such that the crystallinity of the formed single crystal thin film which comprises as the main ingredients at least one or more materials selected from a gallium nitride, an indium nitride, and an aluminum nitride is not more than 240 seconds as half width of the rocking curve of the X-ray diffraction line from the lattice plane of a Miller Index (002), is easy to be obtained.

Moreover, in the substrate of a sintered compact which comprises an aluminum nitride as the main ingredients and whose content of at least one or more ingredients selected from Mo, W, V, Nb, Ta, Ti, and carbon is not more than 5 volume % by element conversion, the still better thing, such that the crystallinity of the formed above-mentioned single crystal thin film is not more than 200 seconds as half width of the rocking curve of the X-ray diffraction line from the lattice plane of a Miller Index (002), is easy to be obtained.

In this invention, it seems that the oxygen contained in the sintered compact which comprises an aluminum nitride as the main ingredients exists in either, it reacts with AlN of the main ingredients and exists as ALON, or it reacts with the rare-earth compound and alkaline-earth-metals compound of sintering aids, and exists as a grain boundary phase, or dissolves in the crystalline lattice of the AlN crystal grain in a sintered compact.

In this invention, as for the total amount of oxygen contained in the sintered compact which comprises an aluminum nitride as the main ingredients, it is preferred that it is not more than 10 weight %.

In the substrate which consists of a sintered compact which comprises an aluminum nitride as the main ingredients and whose total amount of oxygen is not more than 10 weight %, the thing excellent in crystallinity, such that the half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and is formed directly on it is not more than 300 seconds, is easy to be obtained.

In the sintered compact whose total amount of oxygen is not more than 5.0 weight %, a single crystal thin film more excellent in crystallinity not more than 240 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride is easy to be formed.

Moreover, in the sintered compact whose total amount of oxygen is not more than 3.0 weight %, a single crystal thin film still more excellent in crystallinity not more than 200 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride is easy to be formed.

This inventor examined that it is a deed about firing at the above-mentioned temperature not less than 1750 degrees C. for not less than 3 hours in a reduced atmosphere if it is required, contained oxygen, the ingredients used as sintering aid, such as a rare-earth compound and an alkaline earth metal compound, or the ingredients used as a firing temperature reduction-ized agent, such as an alkali metal and silicon, or the metal ingredients and carbon which are used as a black-ized agent, such as Mo, W, V, Nb, Ta, and Ti, or unescapable metal ingredients other than Mo, W, V, Nb, Ta, and Ti etc. are dispersed and removed, and are decreased, and examined the substrate characteristics at the time of an activity further as a substrate for forming directly the thin film which comprises as the main ingredients at least one or more materials selected from a gallium nitride, an indium nitride, and an aluminum nitride in the sintered compact which comprises an aluminum nitride as the main ingredients with a high AlN purity by which the content of the compound containing metal ingredients, silicon, or carbon other than ALON as a crystal phase or the above-mentioned aluminum was reduction-ized.

The above-mentioned characteristics as the sintered compact which comprises an aluminum nitride as the main ingredients and the characteristics of the thin film substrate in which the thin film which comprises as the main ingredients at least one or more materials selected from a gallium nitride, an indium nitride, and an aluminum nitride was formed directly were investigated.

In the above-mentioned sintered compact which comprises an aluminum nitride as the main ingredients, AlN purity tends to become so high that firing time is lengthened again so that firing temperature becomes high.

As firing temperature, not less than 1900 degrees C. are more preferred, not less than 2050 degrees C. are still more preferred, and not less than 2100 degrees C. are the most preferred.

When raising the AlN purity of a sintered compact which comprises an aluminum nitride as the main ingredients, if firing temperature is raised, firing time can be shortened, and it has a relation that firing time will become long if firing temperature is made low, and an effect is almost the same in either.

In order to raise the purity of AlN, it is usually preferred to make the firing time not less than 10 hours in the range of a firing temperature of 1750 degrees C.-1900 degrees C.

It is preferred to have firing time not less than 6 hours in firing temperature not less than 1900 degrees C., firing time not less than 4 hours in firing temperature not less than 2050 degrees C., and firing time not less than 3 hours in firing temperature not less than 2100 degrees C.

Using such method, what has the composition whose content of at least one or more materials selected from a rare earth element and an alkaline earth metal is a total of not more than 0.5 weight % (5000 ppm) by element conversion and whose oxygen content is not more than 0.9 weight % can be obtained as the sintered compact according to this invention which comprises an aluminum nitride as the main ingredients and raised the AlN purity.

Using the sintered compact which comprises an aluminum nitride as the main ingredients and which raised the AlN purity of such composition as a substrate, as for the single crystal thin film which comprises as the main ingredients at least one or more materials selected from a gallium nitride, an indium nitride, and an aluminum nitride and is directly formed on this substrate, what has excellent crystallinity is obtained.

In this invention, as this sintered compact which comprises an aluminum nitride as the main ingredients and which raised the AlN purity, what has the composition whose content of at least one or more materials selected from a rare earth element and an alkaline earth metal is a total of not more than 0.2 weight % (2000 ppm) by element conversion and whose oxygen content is not more than 0.5 weight % can be obtained, it is preferable.

And, in this invention, as the sintered compact which comprises an aluminum nitride as the main ingredients and which raised the AlN purity, what has the composition whose content of at least one or more materials selected from a rare earth element and an alkaline earth metal is a total of not more than 0.05 weight % (500 ppm) by element conversion and whose oxygen content is not more than 0.2 weight % can be obtained, it is more preferable.

And, as this sintered compact which comprises an aluminum nitride as the main ingredients and which raised the AlN purity, what has the composition whose content of at least one or more materials selected from a rare earth element and an alkaline earth metal is a total of not more than 0.02 weight % (200 ppm) by element conversion and whose oxygen content is not more than 0.1 weight % can be obtained, it is still more preferable.

And, as this sintered compact which comprises an aluminum nitride as the main ingredients and which raised the AlN purity, what has the composition whose content of at least one or more materials selected from a a rare earth element and an alkaline earth metal is a total of not more than 0.005 weight % (50 ppm) by element conversion and whose oxygen content is not more than 0.05 weight % can be obtained, it is the most preferable.

Using as a substrate the sintered compact which comprises an aluminum nitride as the main ingredients and which raised the AlN purity, this inventor investigated the quality of the produced thin film by making the thin film which comprises as the main ingredients at least one or more materials selected from a gallium nitride, an indium nitride, and an aluminum nitride grow up on this substrate directly.

The formed thin film is a single crystal, and the quality of a thin film was estimated according to the crystallinity of the single crystal thin film.

As a result, as the sintered compact which comprises an aluminum nitride as the main ingredients and which raised AlN purity, when what has the composition whose content of at least one or more materials selected from a rare earth element and an alkaline earth metal is a total of not more than 0.5 weight % by element conversion and whose oxygen content is not more than 0.9 weight % is used as a substrate, what has good crystallinity, such that the half width of the rocking curve of the X-ray diffraction line from the lattice plane of a Miller Index (002) is not more than 240 seconds, is easy to be obtained as the single crystal thin film which comprises as the main ingredients at least one or more materials selected from a gallium nitride, an indium nitride, and an aluminum nitride and is formed there directly.

Moreover, as the sintered compact which comprises an aluminum nitride as the main ingredients and which raised AlN purity, when what has the composition whose content of at least one or more materials selected from a rare earth element and an alkaline earth metal is a total of not more than 0.2 weight % by element conversion and whose oxygen content is not more than 0.5 weight % is used as a substrate, what has better crystallinity, such that the half width of the rocking curve of the X-ray diffraction line from the lattice plane of a Miller Index (002) is not more than 200 seconds, is easy to be obtained as the above-mentioned single crystal thin film which is formed there directly, it is preferable.

Moreover, as the sintered compact which comprises an aluminum nitride as the main ingredients and which raised AlN purity, when what has the composition whose content of at least one or more materials selected from a rare earth element and an alkaline earth metal is a total of not more than 0.05 weight % by element conversion and whose oxygen content is not more than 0.2 weight % is used as a substrate, what has better crystallinity, such that the half width of the rocking curve of the X-ray diffraction line from the lattice plane of a Miller Index (002) is not more than 150 seconds, is easy to be obtained as the above-mentioned single crystal thin film which is formed there directly, it is more preferable.

Moreover, as the sintered compact which comprises an aluminum nitride as the main ingredients and which raised AlN purity, when what has the composition whose content of at least one or more materials selected from a rare earth element and an alkaline earth metal is a total of not more than 0.02 weight % by element conversion and whose oxygen content is not more than 0.1 weight % is used as a substrate, what has better crystallinity, such that the half width of the rocking curve of the X-ray diffraction line from the lattice plane of a Miller Index (002) is not more than 130 seconds, is easy to be obtained as the above-mentioned single crystal thin film which is formed there directly, it is still more preferable.

As the sintered compact which comprises an aluminum nitride as the main ingredients and which raised AlN purity, when what has the composition whose content of at least one or more materials selected from a rare earth element and an alkaline earth metal is a total of not more than 0.005 weight % by element conversion and whose oxygen content is not more than 0.05 weight % is used as a substrate, what has better crystallinity, such that the half width of the rocking curve of the X-ray diffraction line from the lattice plane of a Miller Index (002) is not more than 100 seconds, is easy to be obtained as the single crystal thin film which is formed there directly, it is most preferable.

AlN of the crystal phase contained in the sintered compact which comprises an aluminum nitride as the main ingredients and which has the composition which raised the above-mentioned AlN purity is not less than 95-98%, crystal phases, such as ALON, and a rare-earth compound or an alkaline earth metal compound, are not more than 2-5%, and what is an AlN single phase substantially is also obtained.

And, what has optical permeability is easy to be obtained, for example, what has the optical transmissivity not less than 1% is easy to be obtained, and what has not less than 5%, not less than 10%, not less than 20%, not less than 30%, not less than 40%, not less than 60%, and not less than 80% are also obtained, what has the optical transmissivity of a maximum of not less than 85% is also obtained.

The crystal phase in the sintered compact which comprises an aluminum nitride as the main ingredients is easily measurable by X-ray diffraction according to carrying out the relative comparison of the strongest line of the diffraction peak in which each crystal phase obtained shows.

If using the above-mentioned method, an aluminum nitride sintered compact with high AlN purity can be manufactured, since the ingredients which are used as a firing temperature reduction-ized agent, such as an alkali metal and silicon, or the ingredients, such as Mo, W, V (vanadium), Nb, Ta, Ti, carbon, etc. which are used as a black-ized agent, or the transition-metals impurities, such as Fe, nickel, Co, Mn, Cr, Zr, Hf, Cu, Zn, etc. which are mixed from aluminum nitride powder raw materials and sintered compact manufacturing processes other than Mo, W, V, Nb, Ta, and Ti, can be vaporized—removed, and reduced, except for oxygen or a rare earth element, or an alkaline earth metal.

As the sintered compact which comprises an aluminum nitride as the main ingredients and raised AlN purity, when what has the composition whose contained alkaline metal and silicon ingredient is a total of not more than 0.2 weight % by element conversion and whose amount of oxygen is not more than 0.9 weight % is used for a substrate, as for the single crystal thin film which comprises as the main ingredients at least one or more materials selected from a gallium nitride, an indium nitride, and an aluminum nitride and is formed there directly, what has good crystallinity, such that the half width of the rocking curve of the X-ray diffraction line from the lattice plane of a Miller Index (002) is not more than 240 seconds, is easy to be obtained.

As the sintered compact which comprises an aluminum nitride as the main ingredients and raised AlN purity, when what has the composition whose Mo, W, V (vanadium), Nb, Ta, Ti, and carbon is a total of not more than 0.2 weight % by element conversion and whose amount of oxygen is not more than 0.9 weight % is used for a substrate, as for the single crystal thin film which comprises as the main ingredients at least one or more materials selected from a gallium nitride, an indium nitride, and an aluminum nitride and is formed there directly, what has good crystallinity, such that the half width of the rocking curve of the X-ray diffraction line from the lattice plane of a Miller Index (002) is not more than 240 seconds, is easy to be obtained.

As the sintered compact which comprises an aluminum nitride as the main ingredients and raised AlN purity, when what has the composition whose Fe, Ni, Co, Mn, Cr, Zr, Hf, Cu, and Zn is a total of not more than 0.2 weight % by element conversion and whose amount of oxygen is not more than 0.9 weight % is used for a substrate, as for the single crystal thin film which comprises as the main ingredients at least one or more materials selected from a gallium nitride, an indium nitride, and an aluminum nitride and is formed there directly, what has good crystallinity, such that the half width of the rocking curve of the X-ray diffraction line from the lattice plane of a Miller Index (002) is not more than 240 seconds, is easy to be obtained.

The rare-earth compound contained in the above-mentioned sintered compact which comprises an aluminum nitride as the main ingredients is a rare earth element, such as Sc, Y, La, Ce, Pr, Nd, Pm, Sm, Eu, Gd, Tb, Dy, Ho, Er, Tm, Yb, and Lu, etc., and a rare earth oxide, such as Sc₂O₃, Y₂O₃, La₂O₃, CeO₂ and Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, etc., or in addition to this, various rare-earth compounds, such as inorganic rare earth compounds, such as carbonate, nitrate, sulfate, and a chloride, and organic rare earth compounds, such as acetate, an oxalate, and citrate, containing Sc, Y, La, Ce, Pr, Nd, Pm, Sm, Eu, Gd, Tb, Dy, Ho, Er, Tm, Yb, Lu, etc.,

and the complex oxide containing various rare earth elements, such as 3Ln₂O₃.5Al₂O₃ of a garnet type crystal structure (for example, 3Y₂O₃.5Al₂O₃, 3Dy₂O₃.5Al₂O₃, 3Ho₂O₃.5Al₂O₃, 3Er₂O₃.5Al₂O₃, 3Yb₂O₃.5Al₂O₃, etc.), Ln₂O₃.Al₂O₃ of a perovskite type crystal structure (for example, YAlO₃, LaAlO₃, PrAlO₃, NdAlO₃, SmAlO₃, EuAlO₃, GdAlO₃, DyAlO₃, ErAlO₃, YbAlO₃, etc.), and monoclinic system crystal structure 2Ln₂O₃.Al₂O₃ (for example, 2Y₂O₃.Al₂O₃, 2Sm₂O₃.Al₂O₃, 2Eu₂O₃.Al₂O₃, 2Gd₂O₃.Al₂O₃, 2Dy₂O₃.Al₂O₃, 2Ho₂O₃.Al₂O₃, 2Er₂O₃.Al₂O₃, 2Yb₂O₃.Al₂O₃) etc., when a rare earth element is expressed with Ln.

The alkaline earth metal compound contained in the above-mentioned aluminum nitride sintered compact is alkaline earth metals, such as Be, Mg, Ca, Sr, and Ba, etc., and alkaline earth metal oxides, such as BeO, MgO, CaO, SrO, and BaO, etc., or, in addition, various alkaline earth metal compounds, such as inorganic alkaline earth metal compounds, such as carbonate, nitrate, sulfate, and chloride, organic alkaline earth metal compounds, such as acetate, oxalate, and citrate, containing Be, Mg, Ca, Sr, and Ba, etc., and further the complex oxides which include an alkaline earth metal, such as 3AeO.Al₂O₃, Ae.Al₂O₃, Ae.2Al₂O₃, and Ae.6Al₂O₃, etc., when an alkaline earth metal element is expressed with Ae.

The feature of the sintered compact which comprises an aluminum nitride as the main ingredients obtained by the method of heating at the temperature not less than 1750 degrees C. for a comparatively long time not less than 3 hours in the above-mentioned reduced atmosphere is that what has the high thermal conductivity not less than 200 W/mK in room temperature is easy to be obtained.

In the sintered compact which comprises an aluminum nitride as the main ingredients, in the case of what has a few impurities content, or what consists of an AlN single phase, furthermore the thing whose thermal conductivity is not less than 220 W/mK in room temperature is easy to be obtained.

In addition to such feature, as for the sintered compact which raised the above-mentioned AlN purity and comprises an aluminum nitride as the main ingredients, the thing whose optical permeability is high is easy to be obtained.

It is surmised that it will be because the ingredients used as a firing temperature reduction-ized agent, such as an alkali metal and silicon, etc., or the ingredients used as a black-ized agent, such as Mo, W, V (vanadium), Nb, Ta, Ti, carbon, etc. or transition-metals impurities mixed from aluminum nitride powder raw materials and sintered compact manufacturing processes other than Mo, W, V, Nb, Ta, and Ti, such as Fe, Ni, Co, Mn, etc. except a rare earth element or an alkaline earth metal, are vaporized, removed and reduced.

Even if it is the sintered compact in which impurities, such as the above-mentioned transition metals, or sintering aids remain, that whose thermal conductivity is not less than 200 W/mK in room temperature, moreover, what has the high thermal conductivity of not less than 220 W/mK, or the sintered compact excellent in optical permeability which comprises an aluminum nitride as the main ingredients, are obtained.

This inventor is probably surmising that this will be to become easier to generate the property of a single crystal of which AlN originally has since the aluminum nitride particle in a sintered compact grows greatly by heating for a long time and the effect of a grain boundary decreases.

According to this invention, the size of the aluminum nitride particle in the sintered compact which comprises an aluminum nitride as the main ingredients in the firing process in which the above-mentioned high purification is performed usually increases.

It seems that increasing the size of the aluminum nitride particle in the above-mentioned sintered compact in which high purification was carried out and which raised AlN purity and comprises an aluminum nitride as the main ingredients is the big factor whose crystallinity of the single crystal thin film which comprises as the main ingredients at least one or more materials selected from a gallium nitride, an indium nitride, and an aluminum nitride and is formed directly on the substrate consisting of a sintered compact comprising an aluminum nitride as the main ingredients increases and whose higher optical transmissivity is given further.

By raising firing temperature or lengthening firing time, it vaporizes, removes and decreases, ingredients other than AlN, such as sintering aids in the sintered compact which comprises an aluminum nitride as the main ingredients, and ingredients other than AlN decrease in the inside of an aluminum nitride particle or in the grain boundary of an aluminum nitride particle in a sintered compact, or it becomes close to zero substantially, in addition to it, the size of the aluminum nitride crystal grain in a sintered compact increases.

It is surmised that in the sintered compact which comprises an aluminum nitride as the main ingredients, ingredients other than AlN decrease in the inside of an aluminum nitride particle, or in the grain boundary of an aluminum nitride particle, or it becomes close to zero substantially, in addition to it, since aluminum nitride particle boundaries (grain boundary) will decrease in number if the size of the aluminum nitride particle in a sintered compact increases, the effect of a grain boundary decreases, high purification of this aluminum nitride particle itself that increased greatly is carried out, crystallinity also increases further and it becomes easy to generate the property near the aluminum nitride of a single crystal with high purity.

That is, since it is the sintered compact which consists of a big crystal grain of the condition near a single crystal with high purity, an optical permeability also comes to have the high optical transmissivity which matches a single crystal in the long wavelength side from near the wavelength 200 nm of the absorption end of an aluminum nitride single crystal.

If this sintered compact is used for a substrate, the single crystal thin film which comprises as the main ingredients at least one or more materials selected from a gallium nitride, an indium nitride, and an aluminum nitride will become that it is easy to be formed by high crystallinity comparable as having used the single crystal of an aluminum nitride as a substrate.

In this invention, although the sintered compact which comprises an aluminum nitride as the main ingredients and raised AlN purity is manufactured by raising firing temperature or by lengthening firing time, the size of the aluminum nitride particle of this sintered compact is usually an average of not less than 5 μm.

Usually, if firing temperature is raised or firing time is lengthened, the size of the aluminum nitride particle in a sintered compact will also increase to an average of not less than 25 μm.

On the experiment, what has the size of about an average of 100 μm of an aluminum nitride particle is obtained.

Thus, it seems that the aluminum nitride particle which increased will be in the condition near a single crystal since AlN purity also increases.

When the sintered compact in which high purification was carried out by the above-mentioned method and which raised AlN purity and comprises an aluminum nitride as the main ingredients is used as a substrate, if the size of the aluminum nitride particle in a sintered compact is an average of not less than 5 μm, the good thing, such that the half width of the rocking curve of the X-ray diffraction line from the lattice plane of the Miller Index (002) of the single crystal thin film which is formed directly on this substrate and comprises as the main ingredients at least one or more materials selected from a gallium nitride, an indium nitride, and an aluminum nitride is not more than 200 seconds, is obtained.

When the substrate whose size of an aluminum nitride particle is an average of not less than 8 μm is uses, the good thing, such that the half width of the rocking curve of the X-ray diffraction line from the lattice plane of the Miller Index (002) of the single crystal thin film which is directly formed on this substrate and comprises as the main ingredients at least one or more materials selected from a gallium nitride, an indium nitride, and an aluminum nitride is not more than 150 seconds, is obtained.

Moreover, when the substrate whose size of an aluminum nitride particle is an average of not less than 15 μm is uses, the good thing, such that the half width of the rocking curve of the X-ray diffraction line from the lattice plane of the Miller Index (002) of the single crystal thin film which is formed directly on this substrate and comprises as the main ingredients at least one or more materials selected from a gallium nitride, an indium nitride, and an aluminum nitride is 130 seconds, is obtained.

Moreover, when the substrate whose size of an aluminum nitride particle is an average of not less than 25 μm is uses, the good thing, such that the half width of the rocking curve of the X-ray diffraction line from the lattice plane of the Miller Index (002) of the single crystal thin film which is directly formed on this substrate and comprises as the main ingredients at least one or more materials selected from a gallium nitride, an indium nitride, and an aluminum nitride is not more than 100 seconds, is obtained.

Thus, the size of the aluminum nitride particle of the sintered compact which comprises an aluminum nitride as the main ingredients and which was made into high purity and is manufactured by vaporizing, removing and decreasing ingredients other than AlN, such as sintering aids, is important.

In this invention, as mentioned above, the sintered compact which comprises an aluminum nitride as the main ingredients and is an average of not less than 5 μm of the size of the aluminum nitride particle in a sintered compact can be provided, what is about an average of 100 μm can be manufactured comparatively easily as the size of the aluminum nitride particle in this sintered compact.

For example, as for the sintered compact which comprises an aluminum nitride as the main ingredients and is obtained by firing the powder compact which uses high purity aluminum nitride powder of 1 μm of mean particle diameter containing oxygen 1 weight % as a raw material and which mixed Y₂O₃ 3.3 volume % (includes 3.9 weight % as Y, and 1.1 weight % as oxygen) as sintering aid and was made into a board-like square with the outside of 60×60 mm and the thickness of 0.8 mm at 1800 degrees C. for 1 hour, the thermal conductivity is in the range of 150 W/mK-180 W/mK in room temperature, the yttrium ingredient in Y₂O₃ used as sintering aid remains in a sintered compact almost as it is, it is admitted that about 5-20% of quantity of the grain boundary phase which comprises as the main substance a rare-earths compound, such as Y₂O₃.5Al₂O₃, YAlO₃, 2Y₂O₃.Al₂O₃, and Y₂O₃, etc., exists by X-ray diffraction.

The quantity of the oxygen of a raw material and the oxygen in Y₂O₃ used as the sintering aid also remain in a sintered compact almost as it is, and the optical transmissivity of this sintered compact is about 10% or is the case not more than it.

In the above-mentioned sintered compact, the size of an aluminum nitride particle is about an average of 2-4 μm.

If this sintered compact is further fired at 2050 degrees C.-2200 degrees C. for 3 hours-24 hours in the nitrogen ambient atmosphere which contains carbon monoxide in the range of 1 ppm-1000 ppm, for example, the oxygen contained in the used raw material and sintering aid decreased to not more than 0.5 weight %, and what is 0.014 weight % was obtained in the case of the fewest one.

Y₂O₃ were almost vaporized and removed, the content became not more than 0.2 weight %, the sintered compact which comprises an aluminum nitride as the main ingredients and has not more than 0.00005 weight % (0.5 ppm) was obtained in the case of the fewest one.

In the light of the range of 200 nm-800 nm wavelength, as for optical transmissivity, at least not less than 10%, many are not less than 20%-60%, and what has a maximum of 88% were obtained.

The phase constitution of a sintered compact is more than 98% of AlN, and what has substantially an AlN single phase was also obtained easily.

The thermal conductivity became more than 200 W/mK-220 W/mK in room temperature, and what has a maximum of 237 W/mK was obtained.

The size of the aluminum nitride particle in this sintered compact was an average of not less than 5-8 μm of minimum, many were growing up greatly into an average of not less than 15 μm-25 μm, and what has a maximum of an average of 74 μm was obtained.

When the sintered compact which comprises an aluminum nitride as the main ingredients and which raised the AlN purity and was illustrated above is used as a substrate, as for the single crystal thin film which was directly formed on this substrate and comprises as the main ingredients at least one or more materials selected from a gallium nitride, an indium nitride, and an aluminum nitride, what indicates the good crystallinity, such that the half width of the rocking curve of the X-ray diffraction line from the lattice plane of a Miller Index (002) is not more than 150 seconds, is obtained, and what is not more than 100 seconds is obtained in what is the best crystallinity.

The sintered compact which comprises an aluminum nitride as the main ingredients and which is produced by the method of vaporizing, removing, and reducing the sintering aid on the firing conditions illustrated above and is made into high purity and whose AlN purity is raised was ground and polished to specular surface with the thickness of 0.5 mm, then optical transmissivity was measured, it was as high as 88% at the wavelength 605 nm.

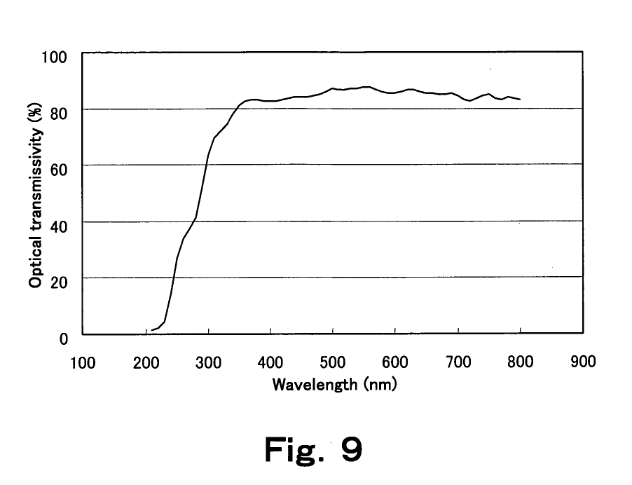

The result is shown in FIG. 9.

As for this sintered compact which comprises an aluminum nitride as the main ingredients used for this optical transmissivity measurement, Y (yttrium) content is not more than 0.0005 weight %, oxygen content is 0.034 weight %, the constitution phase is substantially an AlN single phase, and the size of an aluminum nitride particle is an average of 29 μm.

As it is clear from FIG. 9, as for the optical transmissivity of this sintered compact which comprises an aluminum nitride as the main ingredients, it should show optical transmissivity not less than 1% in the light of a 210-220 nm wavelength, optical transmissivity not less than 5% in the light of a 220 nm-230 nm wavelength, optical transmissivity is not less than 30% in the light of a 250 nm wavelength, optical transmissivity is not less than 60% in the light of a 300 nm wavelength, and optical transmissivity not less than 80% comes to be shown in the light of a 330 nm wavelength, optical transmissivity not less than 80% is shown in the light of all wavelength of the wavelength not less than 330 nm.

The maximum of optical transmissivity is 85-88% in the light of the range of 480 nm -650 nm wavelength, it is as high as not less than 85%.

When this sintered compact which comprises an aluminum nitride as the main ingredients is used as a substrate, as for the crystallinity of the single crystal thin film which was directly formed on this substrate and comprises as the main ingredients at least one or more materials selected from a gallium nitride, an indium nitride, and an aluminum nitride, the good thing, such that the half width of the rocking curve of the X-ray diffraction line from the lattice plane of a Miller Index (002) is not more than 100 seconds, was obtained.

If the main validity is summarized when using the above-mentioned sintered compact which comprises an aluminum nitride as the main ingredients and raised the AlN purity as a substrate, 1) since what is the high crystallinity in the single crystal thin film which comprises as the main ingredients at least one or more materials selected from a gallium nitride, an indium nitride, and an aluminum nitride and is formed on a substrate is easy to be obtained, the luminous efficiency from the inside of a light emitting device manufactured using this single crystal thin film will become high, 2) what has as high as not less than 200 W/mK in room temperature is easy to be obtained as thermal conductivity of a substrate, applying of big electric power is attained into the light emitting device formed on such a substrate, and an emitting output can be heightened, 3) since optical transmissivity of a substrate is high in the light of the range of 200 nm -800 nm wavelength, the optical absorption by a substrate is few, a great portion of light which came out of the light emitting device is emitted to the device exterior, etc.

Namely, as for the manufacture of a light emitting device, what is high efficiency, high output, and low cost has become possible, the influence which gives to industry is large.

In this invention, the sintered compact which comprises an aluminum nitride as the main ingredients and which has optical permeability usually shows an optical permeability in the light with a wavelength not less than 200 nm.

As illustrated in FIG. 9, it was confirmed that there is a tendency whose optical permeability starts to be shown in the light of the range of 200 nm-250 nm wavelength, goes up rapidly in the light of the range of 250 nm-350 nm wavelength, and will be mostly fixed in the light of 350 nm-400 nm or more wavelength.

In this invention, unless reference is made especially, although the optical transmissivity of a sintered compact which comprises an aluminum nitride as the main ingredients means the optical transmissivity measured by the light with a wavelength 605 nm, even if it uses the optical transmissivity in light with a wavelength 605 nm, the performances of the sintered compact which comprises an aluminum nitride as the main ingredients according to this invention, that is, the crystallinity when forming directly the single crystal thin film which comprises as the main ingredients at least one or more materials selected from a gallium nitride, an indium nitride, and an aluminum nitride can be distinguished representatively.

Speaking more concretely, in this invention, unless reference is made especially, the optical transmissivity is usually the optical transmissivity to the light with a wavelength 605 nm.

Although the sintered compact which comprises an aluminum nitride as the main ingredients and has not less than 1% of such optical transmissivity does not necessarily have the optical transmissivity not less than 1% in the light of the range of 200 nm-800 nm wavelength except the wavelength 605 nm, it can form the single crystal thin film which has the excellent crystallinity and comprises as the main ingredients at least one or more materials selected from a gallium nitride, an indium nitride, and an aluminum nitride by using this sintered compact which comprises an aluminum nitride as the main ingredients as a substrate.

In this invention, although as for the sintered compact which comprises an aluminum nitride as the main ingredients used as a substrate for forming the single crystal thin film which comprises as the main ingredients at least one or more materials selected from a gallium nitride, an indium nitride, and an aluminum nitride, what has the optical transmissivity not less than 1% to the light of any wavelength in the range of 200 nm-800 nm wavelength is desirable, even if it does not have the optical transmissivity not less than 1% to all wavelength, what has the optical transmissivity at least not less than 1% to the light with a wavelength 605 nm is desirable.

And, in this invention, the thin film which comprises as the main ingredients at least one or more materials selected from a gallium nitride, an indium nitride, and an aluminum nitride and which is various crystallized states, such as an amorphous state, a polycrystal, and an orientated polycrystal other than the single crystal, can also be formed by using as a substrate the sintered compact which has transmissivity not less than 1% and comprises an aluminum nitride as the main ingredients.

In this invention, although the sintered compact which comprises an aluminum nitride as the main ingredients and has a high AlN purity and whose aluminum nitride particle grew up is preferred as a substrate for forming a single crystal thin film, even if the purity of AlN is not necessarily high, namely, even if it is the sintered compact which comprises an aluminum nitride as the main ingredients and whose ingredients, such as sintering aid, such as a rare-earth compound and an alkaline earth metal compound, or oxygen, or ingredients used as a firing temperature reduction-ized agent, such as an alkali metal and silicon, or the metal ingredients, such as Mo, W, V, Nb, Ta, and Ti, and carbon which are used as a black-ized agent, or unescapable metal ingredients other than Mo, W, V, Nb, Ta, and Ti, or the above-mentioned metal ingredients other than aluminum and silicon, or the compound containing carbon, etc., remain much comparatively, if an aluminum nitride particle has grown up, it can become the substrate on which the single crystal thin film of high crystallinity which comprises as the main ingredients at least one or more materials selected from a gallium nitride, an indium nitride, and an aluminum nitride can form.

This sintered compact which used the aluminum nitride as the main ingredients in which comparatively lots of ingredients other than an aluminum nitride and aluminum nitride particles grew up, as it can be the above-mentioned, is producible by firing at comparatively high temperature of above 1750 degrees C. and for a long time not less than 3 hours in the non-oxidizing atmosphere which does not contain reduction nature ingredients as much as possible.

That is, if the size of the aluminum nitride particle contained inside the sintered compact which comprises an aluminum nitride as the main ingredients containing comparatively lots of ingredients, such as the above-mentioned rare earth element, alkaline earth metal, oxygen, alkali metal, silicon, metal ingredient of Mo, W, V, Nb, Ta, Ti, etc., carbon, unescapable metal ingredient other than Mo, W, V, Nb, Ta, and Ti, ALON, above-mentioned metal ingredients other than aluminum, etc., is an average of not less than 1 μm, what is not more than 300 seconds as half width of the rocking curve of the X-ray diffraction line from the lattice plane of the Miller Index (002) of the single crystal thin film directly formed on the substrate which consists of this sintered compact is easy to be formed.

In the sintered compact whose size of an aluminum nitride particle grew up into an average of not less than 5 μm, the thing excellent in crystallinity not more than 240 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and which is directly formed on this substrate is easy to be obtained.

In the sintered compact whose size of an aluminum nitride particle grew up into an average of not less than 8 μm, the thing more excellent in crystallinity not more than 200 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and which is directly formed on this substrate is easy to be obtained.

In the sintered compact whose size of an aluminum nitride particle grew up into an average of not less than 15 μm, the thing still more excellent in crystallinity not more than 150 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and which is directly formed on this substrate is easy to be obtained.

In the sintered compact whose size of an aluminum nitride particle grew up into an average of not less than 25 μm, the thing still more excellent in crystallinity not more than 130 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and which is directly formed on this substrate is easy to be obtained.

Since the area of the grain boundary of an aluminum nitride crystal grain will decrease and the effect of a grain boundary will reduce, if the size of the aluminum nitride particle inside a sintered compact becomes large, the property of the aluminum nitride crystal grain itself will become easy to be revealed, it is surmised that it will be easy to make the nuclear growth direction of the single crystal thin film which comprises as the main ingredients at least one or more materials selected from a gallium nitride, an indium nitride, and an aluminum nitride more regular.

In this invention, as above-mentioned, by raising the firing temperature or by lengthening firing time in a non-oxidizing atmosphere which does not contain reduction nature ingredients as much as possible, although that the aluminum nitride particle grew up also in the sintered compact which comprises an aluminum nitride as the main ingredients containing comparatively lots of ingredients, such as a rare-earth element, an alkaline earth metal, oxygen, an alkali metal, silicon, the metal ingredients such as Mo, W, V, Nb, Ta, and Ti, etc., carbon, unescapable metal ingredients other than Mo, W, V, Nb, Ta, and Ti, ALON, metal ingredients other than the above-mentioned aluminum, etc., is manufactured, the size of the aluminum nitride particle which grew up in this sintered compact is usually an average of not less than 5 μm.

Usually, if firing temperature is raised or firing time is lengthened, the size of the aluminum nitride particle in a sintered compact will also increase to an average of not less than 8 μm, furthermore to an average of not less than 15 μm, still furthermore to an average of not less than 25 μm, on an experiment, what has about an average of 100 μm as size of an aluminum nitride particle is also obtained.

In this invention, as above-mentioned, by raising the firing temperature or lengthening firing time in a non-oxidizing atmosphere which does not contain reduction nature ingredients as much as possible, although what has any composition can be used if it is what comprises an aluminum nitride as the main ingredients (for example, containing not less than 50 volume % as AlN) as the sintered compact which comprises an aluminum nitride as the main ingredients and contains comparatively lots of ingredients, such as a rare earth element, an alkaline earth metal, oxygen, an alkali metal, silicon, the metal ingredients, such as Mo, W, V, Nb, Ta, and Ti, etc., carbon, unescapable metal ingredients other than Mo, W, V, Nb, Ta, and Ti, ALON, metal ingredients other than the above-mentioned aluminum, etc., and whose aluminum nitride particle grows, among them it is preferred to use the thing of a composition in which the content of at least one or more materials selected from a rare earth element or an alkaline earth metal is not more than 25 volume % by oxide conversion, oxygen content is not more than 10 weight %, content of at least one or more ingredients selected from an alkali metal or silicon is not more than 10 volume % by oxide conversion, content of ingredients which contain at least one or more elements selected from Mo, W, V, Nb, Ta, Ti, and carbon is not more than 25 volume % by element conversion, content of ingredients which contain transition metal other than a rare earth element and Mo, W, V, Nb, Ta, and Ti, such as iron, nickel, chromium, manganese, zirconium, hafnium, cobalt, copper, and zinc is a total of not more than 30 weight % by element conversion, and content of ALON is not more than 20%.

If it is the above composition, even if it is the sintered compact which comprises an aluminum nitride as the main ingredients whose purity of AlN is not necessarily high, that the particle of an aluminum nitride grew up can be used as a substrate for formation of the outstanding single crystal thin film which comprises as the main ingredients at least one or more materials selected from the a gallium nitride, an indium nitride, and an aluminum nitride.

The direct formation of the above-mentioned thin film of the single crystal state which comprises as the main ingredients at least one or more materials selected from a gallium nitride, an indium nitride, and an aluminum nitride can be carried out on the substrate which has such composition in which the particle of an aluminum nitride grew up, further the thin film of various crystallized states other than a single crystal, such as amorphouses, a polycrystal, and an orientated polycrystal, can also be formed.

If it is the above composition, even if it is the sintered compact which comprises an aluminum nitride as the main ingredients whose purity of AlN is not necessarily high, by using that the particle of an aluminum nitride grew up as a substrate, the outstanding single crystal thin film substrate in which the single crystal thin film which comprises as the main ingredients at least one or more materials selected from a gallium nitride, an indium nitride, and an aluminum nitride was formed can manufacture.

The thin film of the single crystal state which comprises as the main ingredients at least one or more materials selected from a gallium nitride, an indium nitride, and an aluminum nitride can be formed furthermore in such single crystal thin film substrate, and the thin film of various crystallized states other than a single crystal, such as an amorphous state, a polycrystal, and an orientated polycrystal, can also be formed furthermore.

As mentioned above, by raising firing temperature or by lengthening firing time, the sintered compact which comprises an aluminum nitride as the main ingredients in which an aluminum nitride particle grows and contains comparatively lots of ingredients, such as a rare earth element, an alkaline earth metal, oxygen, an alkali metal, silicon, metal ingredients of Mo, W, V, Nb, Ta, Ti, etc., carbon, unescapable metal ingredients other than Mo, W, V, Nb, Ta, and Ti, ALON, above-mentioned metal ingredients other than aluminum, etc., is easy to be obtained by firing in the firing environments which do not contain reduction nature ingredients, such as hydrogen, carbon monoxide, carbon, and hydrocarbon, as much as possible.

In this invention, as mentioned above, as for the sintered compact which comprises an aluminum nitride as the main ingredients and is used as a substrate for thin film formation, it is preferred to use the thing of a composition in which the content of at least one or more materials selected from a rare earth element or an alkaline earth metal is not more than 25 volume % by oxide conversion, oxygen content is not more than 10 weight %, content of at least one or more ingredients selected from an alkali metal or silicon is not more than 10 volume % by oxide conversion, content of ingredients which contain at least one or more elements selected from Mo, W, V, Nb, Ta, Ti, and carbon is not more than 25 volume % by element conversion, content of ingredient which contains transition metal other than a rare earth element and Mo, W, V, Nb, Ta, and Ti is not more than 30 weight % by element conversion, and content of ALON is not more than 20%.

If the sintered compact which comprises an aluminum nitride as the main ingredients and which has such composition is used as a substrate for thin film formation, the thing of crystallinity not more than 300 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride is easy to be obtained.

In this invention, although it is preferred that it is not less than 50 volume % as the content of the aluminum nitride ingredient of a sintered compact which comprises an aluminum nitride as the main ingredients, even when what contains comparatively lots of ingredients other than an aluminum nitride, such that, the thing in which the content of at least one or more materials selected from a rare earth element or an alkaline earth metal in this sintered compact is not more than 50 volume % by oxide conversion, the thing in which the oxygen content is not more than 25 weight %, the thing in which the content of at least one or more ingredients selected from an alkali metal or silicon is not more than 20 volume % by oxide conversion, the thing in which the content of ingredients which contain at least one or more elements selected from Mo, W, V, Nb, Ta, Ti, and carbon is not more than 50 volume % by element conversion, the thing in which the content of ingredient which contains transition metal other than a rare earth element and Mo, W, V, Nb, Ta, and Ti, such as iron, nickel, chromium, manganese, zirconium, hafnium, cobalt, copper, and zinc, is not more than 50 weight % by element conversion, and the thing in which the content of ALON is not more than 50%, is used as a substrate for thin film formation, as for the single crystal thin film which comprises as the main ingredients at least one or more materials selected from the a gallium nitride, an indium nitride, and an aluminum nitride and is formed on this substrate, what is the crystallinity, such that the half width of the rocking curve of the X-ray diffraction line from the lattice plane of a Miller Index (002) is not more than 3600 seconds at least, is easy to be obtained, and what is the crystallinity, such that the half width is not more than 300 seconds, is also obtained.

Moreover, in the above-mentioned sintered compact which comprises an aluminum nitride as the main ingredients containing comparatively lots of ingredients other than aluminum nitride, when what contains simultaneously at least one or more materials selected from a rare earth element and at least one or more ingredients selected from an alkaline earth metal which are Included in this sintered compact not more than 50 volume % by oxide conversion, the thing in which the content of oxygen in this sintered compact is not more than 25 weight % and which contains simultaneously at least one or more ingredients selected from a rare earth element or an alkaline earth metal, the thing in which the content of at least one or more ingredients selected from an alkali metal or silicon in this sintered compact is not more than 20 volume % by oxide conversion and which contains simultaneously at least one or more ingredients selected from a rare earth element or an alkaline earth metal, the thing in which the content of ingredients containing at least one or more elements selected from Mo, W, V, Nb, Ta, Ti, and carbon in this sintered compact is not more than 50 volume % by element conversion and which contains simultaneously at least one or more ingredients selected from a rare earth element or an alkaline earth metal, the thing in which the content of ingredients containing transition metal other than a rare earth element and Mo, W, V, Nb, Ta, and Ti, such as iron, nickel, chromium, manganese, zirconium, hafnium, cobalt, copper, and zinc in this sintered compact is not more than 50 weight % by element conversion and which contains simultaneously at least one or more ingredients selected from a rare earth element or an alkaline earth metal, and the thing in which the content of ALON in this sintered compact is not more than 50% and which contains simultaneously at least one or more ingredients selected from a rare earth element or an alkaline earth metal, are used as a substrate for thin film formation, what is the crystallinity, such that the half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride is not more than 300 seconds, is still easier to be obtained.

Namely, if the sintered compact which comprises an aluminum nitride as the main ingredients and which contains simultaneously a rare earth element and an alkaline earth metal ingredient or contains simultaneously ingredients, such as oxygen, alkali metal, silicon, Mo, W, V, Nb, Ta, Ti, carbon, iron, nickel, chromium, manganese, zirconium, hafnium, cobalt, copper, zinc, and ALON, etc., and at least one or more ingredients selected from a rare earth element or an alkaline earth metal is used as a substrate for thin film formation, the crystallinity of the single crystal thin film which is formed on this substrate and comprises as the main ingredients at least one or more materials selected from a gallium nitride, an indium nitride, and an aluminum nitride tends to improve if comparing with the case where the sintered compact which comprises an aluminum nitride as the main ingredients and which contains alone ingredient, such as a rare earth element, an alkaline earth metal, oxygen, an alkali metal, silicon, Mo, W, V, Nb, Ta, Ti, carbon, iron, nickel, chromium, manganese, zirconium, hafnium, cobalt, copper, zinc, and ALON etc, respectively is used as a substrate for single crystal thin film formation.

In addition, as above-mentioned, also in the sintered compact which comprises an aluminum nitride as the main ingredients and which contains simultaneously a rare earth element and an alkaline earth metal ingredient or contains simultaneously ingredients, such as oxygen, alkali metal, silicon, Mo, W, V, Nb, Ta, Ti, carbon, iron, nickel, chromium, manganese, zirconium, hafnium, cobalt, copper, zinc, and ALON, etc., and at least one or more ingredients selected from a rare earth element or an alkaline earth metal, it is preferred that the content of an aluminum nitride ingredient is not less than 50 volume %.

If the content of an aluminum nitride ingredient is smaller than 50 volume %, since formation of the single crystal thin film which comprises as the main ingredients at least one or more materials selected from a gallium nitride, an indium nitride, and an aluminum nitride tends to become difficult, it is not desirable.

Namely, it is preferred to use the sintered compact which comprises an aluminum nitride as the main ingredients and which has a composition, such as the thing in which the sintered compact which comprises an aluminum nitride as the main ingredients contains simultaneously at least one or more ingredients selected from a rare earth element and an alkaline earth metal a total of not more than 50 volume %, the thing in which the content of at least one or more ingredients selected from an alkaline metal or silicon in this sintered compact is not more than 20 volume % by oxide conversion and which contains simultaneously at least one or more ingredients selected from a rare earth element or an alkaline earth metal a total of not more than 50 volume %, the thing in which the content of the ingredients which contains at least one or more elements selected from Mo, W, V, Nb, Ta, Ti, and carbon in this sintered compact is not more than 50 volume % by element conversion and which contains simultaneously at least one or more ingredients selected from a rare earth element or an alkaline earth metal a total of not more than 50 volume %, the thing in which the content of the ingredient which contains transition metal other than a rare earth element and Mo, W, V, Nb, Ta, and Ti, such as iron, nickel, chromium, manganese, zirconium, hafnium, cobalt, copper, and zinc in this sintered compact is not more than 50 weight % by element conversion and which contains simultaneously at least one or more ingredients selected from a rare earth element or an alkaline earth metal a total of not more than 50 volume %, the thing in which the ALON content in this sintered compact is not more than 50% and which contains simultaneously at least one or more ingredients selected from a rare earth element or an alkaline earth metal a total of not more than 50 volume %, and the thing in which the oxygen content in this sintered compact is not more than 25 weight % and which contains simultaneously at least one or more ingredients selected from a rare earth element or an alkaline earth metal a total of not more than 50 volume %.

Thus, when the sintered compact which comprises an aluminum nitride as the main ingredients and which contains a rare earth element and an alkaline earth metal ingredient simultaneously or contains simultaneously ingredients, such as oxygen, an alkali metal, silicon, Mo, W, V, Nb, Ta, Ti, carbon, iron, nickel, chromium, manganese, zirconium, hafnium, cobalt, copper, zinc, and ALON, etc., and at least one or more ingredients selected from a rare earth element or an alkaline earth metal is used as a substrate for forming a single crystal thin film, the crystallinity of the single crystal thin film which is formed on this substrate and comprises as the main ingredients at least one or more materials selected from a gallium nitride, an indium nitride, and an aluminum nitride tends to improve if comparing with the case where the sintered compact which comprises an aluminum nitride as the main ingredients and which contains alone ingredient, such as a rare earth element, an alkaline earth metal, oxygen, an alkali metal, silicon, Mo, W, V, Nb, Ta, Ti, carbon, iron, nickel, chromium, manganese, zirconium, hafnium, cobalt, copper, zinc, and ALON, etc., respectively is used as a substrate for single crystal thin film formation, however, it is not necessarily clear about the reason.

This inventor surmises that if a rare earth element and an alkaline earth metal ingredient are included simultaneously, or ingredients, such as oxygen, an alkali metal, silicon, Mo, W, V, Nb, Ta, Ti, carbon, iron, nickel, chromium, manganese, zirconium, hafnium, cobalt, copper, zinc, and ALON, etc., and at least one or more ingredients selected from a rare earth element or an alkaline earth metal are included simultaneously, a densification becomes possible with firing temperature low about 50 degrees C.-300 degrees C., then it is easy to generate the liquid phase comparatively so much, if it is compared, when each ingredient is included alone, respectively, therefore, the microcrystal of the aluminum nitride particle which constitutes the above-mentioned sintered compact which comprises an aluminum nitride as the main ingredients grows spontaneously in this liquid phase, and crystallinity improves, as a result, crystal alignment of this single crystal thin film is promoted in the process in which the above-mentioned single crystal thin film is formed on the sintered compact which comprises an aluminum nitride as the main ingredients.

When the above-mentioned sintered compact which comprises an aluminum nitride as the main ingredients and which contains a rare earth element and an alkaline earth metal ingredient simultaneously or contains simultaneously ingredients, such as oxygen, an alkali metal, silicon, Mo, W, V, Nb, Ta, Ti, carbon, iron, nickel, chromium, manganese, zirconium, hafnium, cobalt, copper, zinc, and ALON etc., and at least one or more ingredients selected from a rare earth element or an alkaline earth metal is used as a substrate for forming a single crystal thin film, the crystallinity of the single crystal thin film which is formed on this substrate and comprises as the main ingredients at least one or more materials selected from a gallium nitride, an indium nitride, and an aluminum nitride tends to improve if comparing with the case where the sintered compact which comprises an aluminum nitride as the main ingredients and contains alone ingredient, such as a rare earth element, an alkaline earth metal, oxygen, an alkali metal, silicon, Mo, W, V, Nb, Ta, Ti, carbon, iron, nickel, chromium, manganese, zirconium, hafnium, cobalt, copper, zinc, and ALON etc., respectively is used as a substrate for single crystal thin film formation, but it does not restrict, only when each above-mentioned ingredient is included comparatively so much.

In this invention, when what contains simultaneously at least one or more materials selected from a rare earth element and at least one or more materials selected from an alkaline earth metal which are included in this sintered compact not more than 25 volume % by oxide conversion, the thing in which the oxygen content in this sintered compact is not more than 10 weight % and which contains simultaneously at least one or more ingredients selected from a rare earth element or an alkaline earth metal, the thing in which the content of at least one or more ingredients selected from an alkali metal or silicon in this sintered compact is not more than 10 volume % by oxide conversion and which contains simultaneously at least one or more ingredients selected from a rare earth element or an alkaline earth metal, the thing in which the content of at least one or more ingredients selected from Mo, W, V, Nb, Ta, Ti, and carbon in this sintered compact is not more than 25 volume % by element conversion and which contains simultaneously at least one or more ingredients selected from a rare earth element or an alkaline earth metal, the thing in which the content of ingredients containing transition metal other than a rare earth element and Mo, W, V, Nb, Ta, and Ti, such as iron, nickel, chromium, manganese, zirconium, hafnium, cobalt, copper, and zinc in this sintered compact is not more than 30 weight % by element conversion and which contains simultaneously at least one or more ingredients selected from a rare earth element or an alkaline earth metal, and the thing in which the content of ALON in this sintered compact is not more than 20% and which contains simultaneously at least one or more ingredients selected from a rare earth element or an alkaline earth metal, are used as a substrate for thin film formation, the crystallinity of the single crystal thin film which comprises as the main ingredients at least one or more materials selected from a gallium nitride, an indium nitride, and an aluminum nitride and formed on this substrate tends to improve, the thing, such that the half width of the rocking curve of the X-ray diffraction line from the lattice plane of a Miller Index (002) is not more than 240 seconds at least, is easy to be obtained.

Moreover, in this invention, when what contains simultaneously at least one or more materials selected from a rare earth element and at least one more materials selected from an alkaline earth metal which are included in this sintered compact not less than 25 volume % by oxide conversion, the thing in which the content of oxygen in this sintered compact is not less than 10 weight % and which contains simultaneously at least one or more ingredients selected from a rare earth element or an alkaline earth metal, the thing in which the content of at least one or more ingredients selected from an alkali metal or silicon in this sintered compact is not less than 10 volume % by oxide conversion and which contains simultaneously at least one or more ingredients selected from a rare earth element or an alkaline earth metal, the thing in which the content of at least one or more ingredients selected from Mo, W, V, Nb, Ta, Ti, and carbon in this sintered compact is not less than 25 volume % by element conversion and which contains simultaneously at least one or more ingredients selected from a rare earth element or an alkaline earth metal, the thing in which the content of ingredients containing transition metal other than a rare earth element and Mo, W, V, Nb, Ta, and Ti, such as iron, nickel, chromium, manganese, zirconium, hafnium, cobalt, copper, and zinc in this sintered compact is not less than 30 weight % by element conversion and which contains simultaneously at least one or more ingredients selected from a rare earth element or an alkaline earth metal, and the thing in which the content of ALON in this sintered compact is not less than 20% and which contains simultaneously at least one or more ingredients selected from a rare earth element or an alkaline earth metal, are used as a substrate for thin film formation, the crystallinity of a single crystal thin film which comprises as the main ingredients at least one or more materials selected from a gallium nitride, an indium nitride, and an aluminum nitride and formed on this substrate tends to improve, the thing, such that the half width of the rocking curve of the X-ray diffraction line from the lattice plane of a Miller Index (002) is not more than 300 seconds at least, can be obtained.

In this invention, when the substrate for forming the single crystal thin film which comprises as the main ingredients at least one or more materials selected from a gallium nitride, an indium nitride, and an aluminum nitride is manufactured, in order to raise the optical transmissivity of the above-mentioned sintered compact which comprises an aluminum nitride as the main ingredients by which high purification was carried out, anything, for example, a cube or a rectangular parallelepiped or the shape of a cylinder, can use as form of the powder compact and sintered compact which are used for firing, it is preferred to use what beforehand has the shape of a board which is easy to process it in the shape of a substrate.

If it is the same volume, it is preferred to use what has bigger surface area than the shape of block, such as a cube, a rectangular parallelepiped, or the shape of a cylinder.

If the thing in which the one-side magnitude is not more than 8 mm is used as the form of the powder compact and a sintered compact which are provided to the above-mentioned firing, the optical transmissivity of the sintered compact which comprises an aluminum nitride as the main ingredients and whose high purification was attained can be raised, it is desirable.

Moreover, it is more preferred to use the thing in which the above-mentioned one side magnitude is not more than 5 mm, it is still more preferred to use what is the one side size of not more than 2.5 mm, and it is most preferred to use what is the one side size of not more than 1 mm.

When the form of the powder compact and a sintered compact which are provided to the above-mentioned firing is board-like, it is desirable to use what is the thickness not more than 8 mm in order to raise the optical transmissivity of the sintered compact which comprises an aluminum nitride as the main ingredients and whose high purification was attained.

As for the thickness of the above-mentioned board-like powder compact and sintered compact, it is more preferred to use what is not more than 5 mm, it is still more preferred to use what is the thickness not more than 2.5 mm, and it is the most preferred to use what is the thickness not more than 1 mm.

If what was shown above is described concretely, for example, even if the sintered compact comprises the substantially same composition and substantially AlN single phase, when the sintered compact which comprises an aluminum nitride as the main ingredients and whose high purification was attained is manufactured by using what has the block-like shape such as the above-mentioned cube and rectangular parallelepiped, or the cylindrical one, or the powder compact and sintered compact which have the one side size of exceeding 8 mm, optical transmissivity lowers if it is compared with what manufactured using the compact and sintered compact which have the shape of a board or one side size of not more than 8 mm, black-ization may increase according to the case and optical transmissivity may lower further.

In order to form the single crystal thin film which comprises as the main ingredients at least one or more materials selected from a gallium nitride, an indium nitride, and an aluminum nitride, as for the smoothness of the surface of the substrate according to this invention which consists of a sintered compact which comprises an aluminum nitride as the main ingredients (namely, substrate for thin film formation) or the surface of the thin film substrate in which this single crystal thin film was formed, it is preferred that average surface roughness Ra is not more than 2000 nm.

It is desirable in order for having the surface smooth nature of such substrate to form the above-mentioned single crystal thin film.

Therefore, in this invention, it is desirable that at least one or more surfaces of the above-mentioned substrate for thin film formation and a thin film substrate have the above smoothness.

In this invention, the substrate which has the average surface roughness not more than Ra 2000 nm can be obtained in the as-fired (as-fire) surface or the lap grinding surface of a sintered compact which comprises an aluminum nitride as the main ingredients.

The single crystal thin film which comprises as the main ingredients at least one or more materials selected from a gallium nitride, an indium nitride, and an aluminum nitride can be formed directly on the substrate which has the average surface roughness not more than Ra 2000 rim, the single crystal thin film, such that the half width of the rocking curve of the X-ray diffraction line from the lattice plane of a Miller Index (002) is not more than 3600 seconds, is easy to be obtained.

More desirable average surface roughness Ra of the substrate is not more than 1000 nm.

The substrate which has the average surface roughness not more than Ra 1000 nm can be obtained in the as-fired (as-fire) surface or the lap grinding surface of a sintered compact which comprises an aluminum nitride as the main ingredients.

The single crystal thin film which comprises as the main ingredients at least one or more materials selected from a gallium nitride, an indium nitride, and an aluminum nitride can be formed directry on the substrate which has the average surface roughness not more than Ra 1000 nm, the single crystal thin film, such that the half width of the rocking curve of the X-ray diffraction line from the lattice plane of a Miller Index (002) is not more than 1000 seconds, is easy to be obtained.

As for average surface roughness Ra of a substrate, it is still more preferred that it is not more than 100 nm.

The substrate which has the average surface roughness not more than Ra 100 nm can be obtained in the as-fired (as-fire) surface or the specular polish surface of the sintered compact which comprises an aluminum nitride as the main ingredients.

The single crystal thin film which comprises as the main ingredients at least one or more materials selected from a gallium nitride, an indium nitride, and an aluminum nitride can be formed directly on the substrate which has the average surface roughness not more than Ra 100 nm, the single crystal thin film, such that the half width of the rocking curve of the X-ray diffraction line from the lattice plane of a Miller Index (002) is not more than 300 seconds, is easy to be obtained.

In the substrate which has the average surface roughness not more than Ra 100 nm, what was made into the specular surface state not more than Ra 60 nm is preferred usually, not more than Ra 30 nm is more preferred, and not more than Ra 20 nm is still more preferably.

The crystallinity of the single crystal thin film formed by processing into a mirror plane condition becomes easy to improve.

In the substrate which consists of a sintered compact which comprises an aluminum nitride as the main ingredients, the single-crystal-ized thin film which comprises as the main ingredients at least one or more materials selected from a gallium nitride, an indium nitride, and an aluminum nitride can be formed on what is the average surface roughness not more than Ra 60 nm, the single crystal thin film, such that the half width of the rocking curve of the X-ray diffraction line from the lattice plane of a Miller Index (002) is not more than 240 seconds, is easy to be obtained.

In the substrate which consists of a sintered compact which comprises an aluminum nitride as the main ingredients, the single-crystal-ized thin film which comprises as the main ingredients at least one or more materials selected from a gallium nitride, an indium nitride, and an aluminum nitride can be formed on what is the average surface roughness not more than Ra 30 nm, the single crystal thin film, such that the half width of the rocking curve of the X-ray diffraction line from the lattice plane of a Miller Index (002) is not more than 200 seconds, is easy to be obtained.

In the substrate which consists of a sintered compact which comprises an aluminum nitride as the main ingredients, the single-crystal-ized thin film which comprises as the main ingredients at least one or more materials selected from a gallium nitride, an indium nitride, and an aluminum nitride can be formed on what is the average surface roughness not more than Ra 20 nm, the single crystal thin film, such that the half width of the rocking curve of the X-ray diffraction line from the lattice plane of a Miller Index (002) is not more than 150 seconds, is easy to be obtained.

When the as-fired (as-fire) surface of the above-mentioned substrate which consists of a sintered compact which comprises an aluminum nitride as the main ingredients is used, it is preferred to use what has the condition of having removed the affix, dust particle, and the projection etc. on the surface of a substrate by brushing or honing using alumina powder etc.

Lap grinding can satisfactorily perform by the method of using an alumina abrasive grain, a silicon carbide abrasive grain, a diamond abrasive grain, etc. with the lap grinding machine usually used.

The usual sandblasting machine etc. can perform blast polish satisfactorily using an alumina abrasive grain, a silicon carbide abrasive grain, etc.

Mirror polishing can satisfactorily perform by the method of using suitably the abradant such as an alumina, a cerium oxide, a diamond, a silicon oxide, or a chromium oxide of a particle, etc. as the main ingredients with the grinder which has tools (Polisher), such as a usual pad made of cloth, a usual polyurethane pad, etc.

In this invention, when forming the single crystal thin film which comprises as the main ingredients at least one or more materials selected from a gallium nitride, an indium nitride, and an aluminum nitride on the substrate for thin film formation which consists of a sintered compact which comprises an aluminum nitride as the main ingredients and the thin film substrate produced by using the sintered compact which comprises an aluminum nitride as the main ingredients as a substrate, the surface state of the substrate and the surface smooth nature are especially important.

This surface state and surface smooth nature are important similarly, for example, when the sintered compact which comprises an aluminum nitride as the main ingredients and whose AlN purity was raised by firing at the temperature not less than 1750 degrees C. for comparatively long time not less than 3 hours, etc., or the sintered compact which comprises an aluminum nitride as the main ingredients and whose aluminum nitride particle grew greatly, or the sintered compact which comprises an aluminum nitride as the main ingredients and whose optical transmissivity was raised, is used as a substrate.

If the thin film which comprises as the main ingredients at least one or more materials selected from a gallium nitride, an indium nitride, and an aluminum nitride is formed on only the one surface of a substrate, the surface of the substrate for thin film formation which consists of a sintered compact which comprises an aluminum nitride as the main ingredients in which this thin film is not formed, and the surface state and surface smooth nature of the thin film substrate produced by using the sintered compact which comprises an aluminum nitride as the main ingredients as a substrate, can choose arbitrary conditions if needed and may differ from the surface state on which this thin film is formed.

In what has the state where it was ground to the specular surface as the surface state of the above-mentioned substrate according to this invention which consists of a sintered compact which comprises an aluminum nitride as the main ingredients, the crystallinity of the single crystal thin film which comprises as the main ingredients at least one or more materials selected from a gallium nitride, an indium nitride, and an aluminum nitride and is directly formed on a substrate has a tendency to become high.

If the as-fired (as-fire) condition is compared with the lap polish condition, there is a tendency for the substrate surface in the condition of having as-fired as crystallinity of the above-mentioned single crystal thin film directly formed in a substrate to be higher.

About such phenomenon, it is surmised that it will be because the degree which makes the nuclear growth direction regular differs at the time of growth of the single crystal thin film which comprises as the main ingredients at least one or more materials selected from a gallium nitride, an indium nitride, and an aluminum nitride by the smoothness of a substrate surface, that is, the degree of the surface roughness of a substrate.

Moreover, for example, the above-mentioned substrate which consists of a sintered compact which comprises an aluminum nitride as the main ingredients and performed the above-mentioned surface treatment, such as as-fired condition, lap polish, blast polish, and specular surface polish is immersed in acid, such as hydrofluoric acid (HF), hydrofluoric-nitric acid (mixed acid of HF+HNO₃), nitric acid (HNO₃), hydrochloric acid (HCl), and sulfuric acid (H₂SO₄), or immersed in organic solvents, such as acetone, isopropyl alcohol, a methylene chloride, and fluorocarbon, or heated and annealed in non-oxidizing atmosphere containing H₂, N₂, Ar, etc., or under decompression, or it carries out, combining these two or more, by performing which processing, it is possible to aim at the improvement of crystallinity of the single crystal thin film formed on the substrate surface, and it can become effective.

As for the reason whose crystallinity of the single crystal thin film formed by performing such processing becomes easy to be improved, this inventor is surmising that it will be because the defect of the dust particle, a projection, a crack, a hollow, etc., or the strain produced by grinding, polishing, etc. on the surface of a substrate are removed or mitigated.

It seems that it is effective in the ability to make average surface roughness smaller Ra not more than 10 nm by performing such processing since the substrate which consists of a sintered compact which comprises an aluminum nitride as the main ingredients is considered to be easy to produce the defect, and the grinding and the polishing strain by particulate omission, chip of a particulate, etc. on the substrate surface since it is the polycrystalline substance with which aluminum nitride particulates gathered.

In this invention, by using as a substrate the sintered compact which comprises an aluminum nitride as the main ingredients, the surface smooth nature of a thin film substrate in which the thin film which comprises as the main ingredients at least one or more materials selected from a gallium nitride, an indium nitride, and an aluminum nitride is being formed is equivalent to the surface state of the sintered compact which comprises an aluminum nitride as the main ingredients and is used usually as a substrate or is improved.

That is, if the smoothness of the surface of the substrate which consists of a sintered compact which comprises an aluminum nitride as the main ingredients is Ra=30 nm as average surface roughness, the surface smoothness of the thin film substrate according to this invention will become not more than Ra 30 nm.

Therefore, as for the smooth nature of the surface of a thin film substrate according to this invention in which the thin film which comprises as the main ingredients at least one or more materials selected from a gallium nitride, an indium nitride, and an aluminum nitride was formed, it is not more than 2000 nm when the substrate consisting of a sintered compact which comprises an aluminum nitride as the main ingredients and whose average surface roughness is not more than Ra=2000 nm is used, it is not more than Ra 1000 nm when the substrate consisting of a sintered compact which comprises an aluminum nitride as the main ingredients and whose average surface roughness is not more than Ra=1000 nm is used, it is not more than Ra 100 nm when the substrate consisting of a sintered compact which comprises an aluminum nitride as the main ingredients and whose average surface roughness is not more than Ra=100 nm is used, it is not more than Ra 20 nm when the substrate consisting of a sintered compact which comprises an aluminum nitride as the main ingredients and whose average surface roughness is not more than Ra=20 nm is used.

As for the smooth nature of the thin film substrate surface in which the thin film which comprises as the main ingredients at least one or more materials selected from a gallium nitride, an indium nitride, and an aluminum nitride was formed using as a substrate the sintered compact which comprises an aluminum nitride as the main ingredients according to this invention, that whose average surface roughness Ra is not more than 10 nm, or what is not more than Ra 3 nm-5 nm, furthermore what is not more than Ra 1 nm-3 nm are also obtained.

In the thin film substrate according to this invention, the thin film which gives surface smooth nature which is equivalent to the surface smooth nature, or is improved more than it, of the substrate which consists of a sintered compact which comprises an aluminum nitride as the main ingredients is not restricted only to a single crystal thin film which comprises as the main ingredients at least one or more materials selected from a gallium nitride, an indium nitride, and an aluminum nitride.

In the case of the thin film substrate according to this invention which formed the thin film which comprises as the main ingredients at least one or more materials selected from a gallium nitride, an indium nitride, and an aluminum nitride and which has at least one of the crystallized states selected from an amorphous state, a polycrystal, and an orientated polycrystal using the substrate which consists of a sintered compact which comprises an aluminum nitride as the main ingredients, like the above-mentioned single crystal thin film, it is equivalent to the surface smooth nature of the substrate which consists of a sintered compact which comprises an aluminum nitride as the main ingredients or it improves more than it, as for the degree of smooth nature, what is not more than Ra 20 nm as average surface roughness, or what is not more than 10 nm, or what is not more than Ra 3 nm-5 nm, further what is not more than Ra 1 nm-3 nm are also obtained.

The further excellent thin film which comprises as the main ingredients at least one or more materials selected from a gallium nitride, an indium nitride, and an aluminum nitride can be formed on the thin film substrate which has such surface smooth nature.

That is, if the single crystal thin film which comprises as the main ingredients at least one or more materials furthermore selected from a gallium nitride, an indium nitride, and an aluminum nitride is formed furthermore on the thin film substrate in which the single crystal thin film which comprises as the main ingredients at least one or more materials selected from a gallium nitride, an indium nitride, and an aluminum nitride by using as a substrate the sintered compact which comprises an aluminum nitride as the main ingredients is being formed, or to the thin film substrate in which the thin film which comprises as the main ingredients at least one or more materials selected from a gallium nitride, an indium nitride, and an aluminum nitride and has at least one of the crystallized states selected from a single crystal, an amorphous state, a polycrystal, and an orientated polycrystal is being formed by using the sintered compact which comprises an aluminum nitride as the main ingredients as a substrate, when the surface smooth nature of the above-mentioned thin film substrate is not more than Ra 50 nm, the single crystal thin film, such that the half width of the rocking curve of the X-ray diffraction line from the lattice plane of the Miller Index (002) of the above-mentioned single crystal thin film which comprises as the main ingredients at least one or more materials selected from a gallium nitride, an indium nitride, and an aluminum nitride and is formed on this thin film substrate is not more than 240 seconds, is easy to be obtained.

And, when the surface smooth nature of the above-mentioned thin film substrate is not more than Ra 20 nm, the single crystal thin film, such that the half width of the rocking curve of the X-ray diffraction line from the lattice plane of the Miller Index (002) of the above-mentioned single crystal thin film which comprises as the main ingredients at least one or more materials selected from a gallium nitride, an indium nitride, and an aluminum nitride and is formed on this thin film substrate is not more than 200 seconds, is easy to be obtained.

When the surface smooth nature of the above-mentioned thin film substrate is not more than Ra 10 nm, the single crystal thin film, such that the half width of the rocking curve of the X-ray diffraction line from the lattice plane of the Miller Index (002) of the above-mentioned single crystal thin film which comprises as the main ingredients at least one or more materials selected from a gallium nitride, an indium nitride, and an aluminum nitride and is formed on this thin film substrate is not more than 150 seconds, is easy to be obtained.

When the surface smooth nature of this above-mentioned thin film substrate is not more than Ra 5 nm, the single crystal thin film, such that the half width of the rocking curve of the X-ray diffraction line from the lattice plane of the Miller Index (002) of the above-mentioned single crystal thin film which comprises as the main ingredients at least one or more materials selected from a gallium nitride, an indium nitride, and an aluminum nitride and is formed on this thin film substrate is not more than 130 seconds, is easy to be obtained.

Moreover, when the surface smooth nature of the above-mentioned thin film substrate is not more than Ra 3 nm, the single crystal thin film, such that the half width of the rocking curve of the X-ray diffraction line from the lattice plane of the Miller Index (002) of the above-mentioned single crystal thin film which comprises as the main ingredients at least one or more materials selected from a gallium nitride, an indium nitride, and an aluminum nitride and is formed on this thin film substrate is not more than 100 seconds, is easy to be obtained.

Not only the above-mentioned single crystal thin film which comprises as the main ingredients at least one or more materials selected from a gallium nitride, an indium nitride, and an aluminum nitride but also the thin film which has at least one of the crystallized states selected from an amorphous state, a polycrystal, and an orientated polycrystal and which comprises as the main ingredients at least one or more materials selected from a gallium nitride, an indium nitride, and an aluminum nitride can be formed on the thin film substrate according to this invention which has such smooth nature.

In the above-mentioned thin film substrate according to this invention, although the thin film which is formed on the substrate consisting of a sintered compact comprising an aluminum nitride as the main ingredients and which gives the surface smooth nature equivalent to the surface smooth nature of the substrate consisting of a sintered compact comprising an aluminum nitride as the main ingredients or is improved more than it is the thing which comprises as the main ingredients at least one or more materials selected from a gallium nitride, an indium nitride, and an aluminum nitride and has at least one of the crystallized states selected from a single crystal, an amorphous state, a polycrystal, and an orientated polycrystal, if the thickness of this thin film is not less than 0.5 nm, the thin film substrate which has the surface smooth nature which is equivalent to surface smooth nature, or is improved more than it, of the substrate which consists of a sintered compact which comprises an aluminum nitride as the main ingredients is obtained.

As mentioned above, the surface smooth nature of a substrate in which the thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal etc., was formed on the substrate which consists of a sintered compact which comprises an aluminum nitride as the main ingredients tends to improve rather than the substrate which consists of a sintered compact which comprises an aluminum nitride as the main ingredients in which the thin film is not formed.

By further forming the thin film of various crystallized states, such as a single crystal, an amorphous state, a polycrystal, and an orientated polycrystal, on the substrate in which the thin film of various crystallized states, such as a single crystal, an amorphous state, a polycrystal, and an orientated polycrystal, was formed beforehand on the above-mentioned substrate which consists of a sintered compact which comprises an aluminum nitride as the main ingredients (a thin film is formed in a multilayer), the surface roughness of a substrate becomes small, and surface smooth nature may be improved further.

The thing whose average surface roughness Ra of this substrate is not more than 10 nm is usually obtained comparatively easily.

When the surface smooth nature of a substrate is improved by forming such multilayered thin film, it is preferred to use the substrate which formed the thin film that has at least one of the crystallized states selected from an amorphous thin film, a polycrystalline thin film, and an orientated polycrystalline thin film among the single crystal thin film, an amorphous thin film, a polycrystalline thin film, and an orientated polycrystalline thin film which are formed beforehand on the substrate which consists of a sintered compact which comprises an aluminum nitride as the main ingredients, and the thin film substrate whose average surface roughness Ra is not more than 3 nm can be produced.

When improving the surface smooth nature of a substrate by forming the above-mentioned multilayered thin film, among a single crystal thin film, an amorphous thin film, a polycrystalline thin film, and an orientated polycrystalline thin film which are formed beforehand on the substrate which consists of a sintered compact which comprises an aluminum nitride as the main ingredients, it is preferred to use the substrate which formed the orientated polycrystalline thin film.

As for the average surface roughness of a substrate in which an orientated polycrystalline thin film was first formed directly on the substrate which consists of a sintered compact which comprises an aluminum nitride as the main ingredients, and a single crystal thin film, an amorphous thin film, a polycrystalline thin film, and an orientated polycrystalline thin film was formed furthermore after that, what is not more than Ra 2 nm at least, furthermore, what is not more than Ra 1 nm are easy to be obtained.

This inventor is surmising that it is a big factor that the difference in surface smooth nature produced when forming a thin film directly on the substrate which consists of a sintered compact which comprises an aluminum nitride as the main ingredients also affects the thin film formed on it as it is although the reason is not necessarily clear in why the effect by the above orientated polycrystalline thin film formation arises.

That is, the surface roughness of the orientated polycrystalline thin film formed on the substrate which consists of a sintered compact which comprises an aluminum nitride as the main ingredients is usually smaller than a single crystal thin film, an amorphous thin film, and a polycrystalline thin film in many cases.

The difference in such surface roughness from the first is considered to be revealed as a difference in the surface roughness of the thin film formed on it as it is.

This inventor is surmising that the original difference in surface roughness will be generated since the degree which complements the defect resulting from sintered compacts, such as the micro hole, projection, and chip of an aluminum nitride particle which exist in the substrate which consists of a sintered compact which comprises an aluminum nitride as the main ingredients is smaller than an orientated polycrystalline thin film, by the cause in which high temperature is comparatively required in many cases when forming a single crystal thin film and a difference of local crystal growth arises in a thin film, or by the cause in which the degree of the density of a thin film is low and in which many micro defects exist in an amorphous thin film and a polycrystalline thin film, for example.

Although such surface smooth nature by the thin film formed on the substrate which consists of a sintered compact which comprises an aluminum nitride as the main ingredients may be produced spontaneously, by using the grinding and polishing devices, and the abradants which were illustrated above, it is attained also by performing mechanochemical (based on mechanical chemical actuation) grinding or specular surface polish.

By performing mechanochemical grinding or specular surface polish, the thing whose average surface roughness Ra of a thin film substrate is at least not more than 10 nm can produce.

A thin film substrate whose average surface roughness Ra is not more than 3 nm, or not more than 2 nm, further not more than 1 nm can produce.

The reason the outstanding smooth nature which is equivalent or more to the sintered compact which comprises an aluminum nitride as the main ingredients is obtained by performing mechanochemical grinding or polishing is surmised because the thin film formed on the sintered compact which comprises an aluminum nitride as the main ingredients consists of a finer particle if it is compared with the sintered compact which comprises an aluminum nitride as the main ingredients, nothing from a particulate etc., or is the homogeneous, continuous, and unified construction (monolithic construction), so there are few defects of nm level.

Moreover, for example, the above-mentioned substrate in which the thin films were formed is immersed in acid, such as hydrofluoric acid (HF), hydrofluoric-nitric acid (mixed acid of HF+HNO₃), nitric acid (HNO₃), hydrochloric acid (HCl), and sulfuric acid (H₂SO₄), or heated and annealed in the non-oxidizing atmosphere containing H₂, N₂, Ar, etc., or under decompression, or it carries out, combining these two or more, by performing which processing, it is possible to aim at the improvement of crystallinity of the single crystal thin film formed on the substrate surface, and it can become effective.

Using the thin film substrate which has such surface smooth nature, if an electronic devices or electronic parts, such as a light emitting device, an optical waveguide, a wiring board, and a surface acoustic wave device, are produced, what has the more excellent characteristics will be easy to be obtained.

Especially the light emitting device which was excellent in luminous efficiency can produce. In this invention, in order to form the thin film which is various crystallized states including the single crystal and comprises as the main ingredients at least one or more materials selected from a gallium nitride, an indium nitride, and an aluminum nitride, as for the smoothness of the surface of the substrate using the sintered compact which consists of a material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc. (namely, substrate for thin film formation), or the surface of the thin film substrate by which the thin film which comprises as the main ingredients at least one or more materials selected from a gallium nitride, an indium nitride, and an aluminum nitride was formed on the above-mentioned substrate for thin film formation, it is preferred that average surface roughness Ra is not more than 1000 nm.

It is desirable in order for having the surface smooth nature of such substrate to form the above-mentioned single crystal thin film.

Therefore, it is desirable that at least one surface of the thin film substrate which is produced using the above-mentioned substrate for thin film formation in this invention has the above smoothness.

The substrate which has the average surface roughness not more than Ra 1000 nm can be obtained at the as-fired (as-fire) surface or lap grinding surface of the sintered compact which consists of a material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., or at the surface of the thin film substrate which is produced by using the above-mentioned substrate for thin film formation on which specular surface polish was performed.

A single-crystal-ized thin film which comprises as the main ingredients at least one or more materials selected from a gallium nitride, an indium nitride, and an aluminum nitride can be formed directly on these substrates that have the average surface roughness not more than Ra 1000 nm, the single crystal thin film, such that the half width of the rocking curve of the X-ray diffraction line from the lattice plane of a Miller Index (002) is not more than 3600 seconds, is easy to be obtained.

As for the surface smooth nature of the thin film substrate produced using the above-mentioned substrate for thin film formation, as the mirror plane condition usually what is not more than Ra 100 nm is preferred, and what is not more than Ra 30 nm is more preferred.

The crystallinity of the single crystal thin film formed by changing into a mirror plane condition becomes easy to improve.

In the substrate using the sintered compact which comprises as the main ingredients the material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., a single-crystal-ized thin film which comprises as the main ingredients at least one or more materials selected from a gallium nitride, an indium nitride, and an aluminum nitride can be formed on the thing whose average surface roughness Ra is not more than 100 nm, the single crystal thin film, such that the half width of the rocking curve of the X-ray diffraction line from the lattice plane of a Miller Index (002) is not more than 1000 seconds, is easy to be obtained.

As for average surface roughness Ra of these substrates, it is more preferred that it is not more than 10 nm.

These substrates that have the average surface roughness not more than Ra 10 nm can be obtained at the surface of the thin film substrate produced by using the above-mentioned substrate for thin film formation to which specular surface polish of the sintered compact which comprises as the main ingredients the material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., was carried out etc.

The single-crystal-ized thin film which comprises as the main ingredients at least one or more materials selected from a gallium nitride, an indium nitride, and an aluminum nitride can be formed directly on the substrate which has the average surface roughness not more than Ra 10 nm, a single crystal thin film, such that the half width of the rocking curve of the X-ray diffraction line from the lattice plane of a Miller Index (002) which is not more than 300 seconds, is easy to be obtained.

As for average surface roughness Ra of these substrates, it is still more preferred that it is not more than 5 nm.

The substrate that has the average surface roughness not more than Ra 5 nm can be obtained at the surface of the thin film substrate produced by using the above-mentioned substrate for thin film formation to which specular surface polish of the sintered compact which comprises as the main ingredients the material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., was carried out etc.

The single-crystal-ized thin film which comprises as the main ingredients at least one or more materials selected from a gallium nitride, an indium nitride, and an aluminum nitride can be formed directly on the substrate which has the average surface roughness not more than Ra 5 nm, and a single crystal thin film, such that the half width of the rocking curve of the X-ray diffraction line from the lattice plane of a Miller Index (002) is not more than 240 seconds, is easy to be obtained.

When using the as-fired (as-fire) surface of the above-mentione substrate which consists of the sintered compact which comprises as the main ingredients a material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., it is preferred to use what is in the condition of having removed the affix, the dust particle, and the projection, etc. on the surface of a substrate by honing which used a brush, alumina abrasive powder, etc.

As for the lap polish, the method using an alumina abrasive grain, a silicon carbide abrasive grain, and a diamond abrasive grain which are usually performed can use satisfactorily with a lap grinding machine.

As for the specular surface polish, the method using suitably the abradant which comprises as the main ingredients an alumina, a cerium oxide, a diamond, a silicon oxide, or a chromium oxide, etc. and which are a particulate can use satisfactorily with the polishing machine which has implement, such as a usual pad made of cloth, and a usual polyurethane pad, etc.

In this invention, in the thin film substrate produced using the substrate for thin film formation which consists of a sintered compact which comprises as the main ingredients the material which can be classified as a hexagonal system such as a silicon carbide, a silicon nitride, a zinc oxide, and a beryllium oxide etc., and classified as a trigonal system or a hexagonal system, such as an aluminum oxide etc., the surface in which a thin film is formed is important especially as for the surface state.

When the thin film which comprises as the main ingredients at least one or more materials selected from a gallium nitride, an indium nitride, and an aluminum nitride is formed on the only one surface of a substrate, the surface state of the thin film substrate produced using the substrate for thin film formation which consists of the sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., can choose arbitrary conditions if needed, it may differ from the surface state in which the thin film which comprises as the main ingredients at least one or more materials selected from a gallium nitride, an indium nitride, and an aluminum nitride is formed.

As for the surface state of the above-mentioned substrate according to this invention which consists of a sintered compact which comprises as the main ingredients the material which has the crystal structure which can be classified as a hexagonal system such as a silicon carbide, a silicon nitride, a zinc oxide, and a beryllium oxide etc., what is in the condition of having ground to the mirror plane has a tendency in which the crystallinity of the single crystal thin film which comprises as the main ingredients at least one or more materials selected from a gallium nitride, an indium nitride, and an aluminum nitride directly formed in a substrate is high.

When what is in the as-fired (as-fire) condition is compared with what is in the lap polish condition, what is in the condition of as-fired substrate surface has a tendency whose crystallinity of the above-mentioned single crystal thin film which is directly formed in a substrate is high.

About such phenomenon, it is surmised that it will be because the degree which makes the nuclear growth direction regular differs at the time of growth of the single crystal thin film which comprises as the main ingredients at least one or more materials selected from a gallium nitride, an indium nitride, and an aluminum nitride by the smoothness of a substrate surface, that is, the degree of the surface roughness of a substrate.

About such phenomenon, although there is a difference in which higher smoothness is requested as the surface of a substrate if it is compared with the case of the substrate which uses the sintered compact which comprises an aluminum nitride as the main ingredients, it is surmised that it will be because the degree which makes the nuclear growth direction regular differs at the time of growth of the single crystal thin film which comprises as the main ingredients at least one or more materials selected from a gallium nitride, an indium nitride, and an aluminum nitride by the smoothness of a substrate surface, that is, the degree of the surface roughness of a substrate.

In this invention, surface smooth nature of a thin film substrate in which the thin film which comprises as the main ingredients at least one or more materials selected from a gallium nitride, an indium nitride, and an aluminum nitride is formed by using as a substrate the sintered compact which comprises as the main ingredients the material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., is usually equivalent to surface smooth nature, or is improved more, of the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc.

That is, if the smoothness on the surface of a substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., is Ra=30 nm as average surface roughness, for example, the surface smoothness of the thin film substrate according to this invention will become Ra not more than 30 nm.

Therefore, the smooth nature of the surface of a thin film substrate according to this invention in which the single crystal thin film which comprises as the main ingredients at least one or more materials selected from a gallium nitride, an indium nitride, and an aluminum nitride was formed is not more than Ra 1000 nm, when the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and has average surface roughness Ra=not more than 1000 nm is used,

it is not more than Ra 100 nm, when the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and has average surface roughness Ra=not more than 100 nm is used,

it is not more than Ra 30 nm, when the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and has average surface roughness Ra=not more than 30 nm is used,

it is not more than Ra 10 nm, when the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and has average surface roughness Ra=not more than 10 nm is used,

it is not more than Ra 5 nm, when the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and has average surface roughness Ra=not more than 5 nm is used.

As for the smooth nature of the thin film substrate surface in which the thin film which comprises as the main ingredients at least one or more materials selected from a gallium nitride, an indium nitride, and an aluminum nitride was formed by using as a substrate the sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., it can obtain what is not more than Ra 10 nm or what is not more than Ra 3 nm-5 nm, or further what is not more than 1 nm-3 nm.

In the thin film substrate according to this invention, the thin film which gives the surface smooth nature which is equivalent to the surface smooth nature, or is improved more than it, of the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., is not restricted only to a single crystal thin film which comprises as the main ingredients at least one or more materials selected from a gallium nitride, an indium nitride, and an aluminum nitride.

In the case of the thin film substrate according to this invention which formed the thin film which comprises as the main ingredients at least one or more materials selected from a gallium nitride, an indium nitride, and an aluminum nitride and which has at least one of the crystallized states selected from an amorphous state, a polycrystal, and an orientated polycrystal by using the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., like the above-mentioned single crystal thin film, equivalent to the surface smooth nature, or it improves more than it, of the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., as for the degree of smooth nature, it can obtain what is not more than Ra 20 nm, or what is not more than Ra 10 nm, or what is not more than Ra 3 nm-5 nm, or further what is not more than 1nm-3 nm.

In the above-mentioned thin film substrate according to this invention, although the thin film which gives the surface smooth nature which is equivalent to surface smooth nature of the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., or is improved more than it is what comprises as the main ingredients at least one or more materials selected from a gallium nitride, an indium nitride, and an aluminum nitride and what has at least one of the crystallized states selected from a single crystal, an amorphous state, a polycrystal, and an orientated polycrystal, if the thickness of this thin film is not less than 0.5 nm, a thin film substrate in which the surface smooth nature is equivalent to the surface smooth nature, or is improved more than it, of the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., is obtained.

As mentioned above, surface smooth nature of a substrate in which the thin film which comprises as the main ingredients at least one or more materials selected from a gallium nitride, an indium nitride, and an aluminum nitride and which has the various crystallized states, such as a single crystal, an amorphous state, a polycrystal, and an orientated polycrystal etc., was formed on the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., is easy to improve rather than the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc.

By forming furthermore the thin film of various crystallized states, such as a single crystal, an amorphous state, a polycrystal, and an orientated polycrystal, on the substrate by which the thin film of various crystallized states, such as a single crystal, an amorphous state, a polycrystal, and an orientated polycrystal, was formed beforehand on the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., (a thin film is formed in a multilayer), the surface roughness of a substrate becomes small, and surface smooth nature may be improved further.

When improving the surface smooth nature of a substrate by forming such multilayer thin film, among a single crystal thin film, an amorphous thin film, a polycrystalline thin film, and an orientated polycrystalline thin film which are first formed directly on a substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., it is preferred to use the substrate which formed the orientated polycrystalline thin film.

First, it forms an orientated polycrystalline thin film directly on the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., as for the surface roughness of the substrate which formed the single crystal thin film, the amorphous thin film, the polycrystalline thin film, and the orientated polycrystalline thin film further after that, what is at least not more than 2 nm and further what is not more than 1 nm are easy to be obtained.

Although the reason is not necessarily clear in why the effect by the above orientated polycrystalline thin film formation arises, this inventor is surmising that it is a big factor that the difference in the surface smooth nature produced when forming a thin film in the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., directly also affects the thin film formed on it as it is.

That is, the surface roughness of the orientated polycrystalline thin film formed on the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., is usually smaller than a single crystal thin film, an amorphous thin film, and a polycrystalline thin film in many cases.

The original difference in such surface roughness is considered to be revealed as a difference in the surface roughness of the thin film formed on it as it is.

This inventor is surmising that the original difference in surface roughness will be generated, for example, since high temperature is comparatively required in many cases when forming a single crystal thin film and a difference of local crystal growth arises in a thin film, or since the degree of density of a thin film is low and many micro defects exist in an amorphous thin film and a polycrystalline thin film, consequently, the degree with which the defect resulting from sintered compacts, such as a micro hole, a projection, and a chip of a sintered compact particle which exists in the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., is complemented is smaller than an orientated polycrystalline thin film.

Although such surface smooth nature by the thin film formed on the substrate which consists of a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., may be produced spontaneously, by using the grinding and polishing devices, and the abrasive powders which were illustrated above, it is attained also by performing mechanochemical grinding or specular surface polish (based on mechanical chemical actuation).

The reason whose outstanding smooth nature which is equivalent or more to a sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., is obtained by performing mechanochemical grinding or polishing is surmised that it will be because there are few defects of nm level, because the thin film formed on each sintered compact is the structure which consists of a more fine particle or is homogeneous, continuously unified from (monolithic structure) which is not a particulate etc. if it is compared with the sintered compact which comprises as the main ingredients the material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc.

For example, the above-mentioned substrate in which the thin films were formed is immersed in acid, such as hydrofluoric acid (HF), hydrofluoric-nitric acid (mixed acid of HF+HNO₃), nitric acid (HNO₃), hydrochloric acid (HCl), and sulfuric acid (H₂SO₄), or heated and annealed in the non-oxidizing atmosphere containing H₂, N₂, Ar, etc., or under decompression, or it carries out, combining these two or more, by performing which processing, it is possible to aim at the improvement of crystallinity of the single crystal thin film formed on the substrate surface, and it can become effective.

This inventor showed that the crystallinity of the single crystal thin film which comprises as the main ingredients at least one or more materials selected from a gallium nitride, an indium nitride, and an aluminum nitride and is formed on a substrate and the transmissivity in visible light and/or the ultraviolet light of the range of 200 nm-380 nm wavelength had correlation, when the sintered compact which comprises an aluminum nitride as the main ingredients as a substrate was used.

Since the rate of light that the rate which absorbs the light from the light emitting device formed on the substrate which consists of a sintered compact which comprises an aluminum nitride as the main ingredients as an advantage when transmissivity is still higher, or from the light emitting device formed on the substrate which formed the single crystal thin film which comprises as the main ingredients at least one or more materials selected from a gallium nitride, an indium nitride, and an aluminum nitride by using the substrate which consists of a sintered compact which comprises an aluminum nitride as the main ingredients is made small, and is emitted to the exterior of a device can raise the luminous efficiency of a light emitting device can be raised.

In order to raise the transmissivity of the substrate which consists of a sintered compact which comprises an aluminum nitride as the main ingredients and which has the above features and advantages, it is also effective to make thickness of a substrate thin besides improving the characteristics of the sintered compact itself, such as chemical composition of a sintered compact and microstructure etc.

If the thickness of a substrate is not more than 8.0 mm, transmission nature can be maintained to the light of the range of 200 nm-800 nm wavelength.

That permeability is maintainable means that transmissivity is not less than 1%, even if the thickness of the substrate which consists of a sintered compact which comprises as the main ingredients an aluminum nitride is 8.0 mm.

Even if the transmissivity measured by using the substrate which consists of a sintered compact which comprises an aluminum nitride as the main ingredients and whose thickness is 0.5 mm is as high as the range of 60-80% in the light of the range of 200 nm-800 nm wavelength, if the thickness of a substrate becomes thick, transmissivity decreases.

For example, when the transmissivity measured by using the substrate with 0.5 mm thickness is 80% in the light of the range of 200 nm-800 nm wavelength, even if the thickness is 8.0 mm, transmissivity is not less than 1% in the light of the range of 200 nm-800 nm wavelength.

If the thickness of a substrate is not more than 5.0 mm, transmissivity not less than 5% is obtained.

If the thickness of a substrate is not more than 2.5 mm, transmissivity not less than 10% is obtained.

If the thickness of a substrate is furthermore not more than 1.0 mm, transmissivity not less than 60% is obtained.

If the thickness of a substrate becomes thin with not more than 0.2 mm, transmissivity not less than 90% is obtained.

When the thickness of a substrate is not more than 0.05 mm, transmissivity not less than 95% is obtained.

When the transmissivity measured by using the substrate with 0.5 mm thickness is 1.0% to the light of the range of 200 nm-800 nm wavelength, if the thickness becomes thin to 0.2 mm, what is transmissivity not less than 10% is obtained.

When the thickness of a substrate is not more than 0.1 mm, transmissivity not less than 20% is obtained.

When the thickness of a substrate is not more than 0.05 mm, transmissivity not less than 40% is obtained.

Thus, in the substrate which consists of a sintered compact which comprises an aluminum nitride as the main ingredients and which has high transmissivity not less than 60% in the light of the range of 200 nm-800 nm wavelength, it has high permeability without being seldom influenced by the thickness of a substrate in case of thickness not more than 1.0 mm, and in case of thickness not more than 0.2 mm it becomes transmissivity of not less than 90% which is almost transparent.

What has the transmissivity near 100% substantially is obtained.

Usually, although transmissivity has an increasing tendency so thin the thickness of a substrate is thin, since mechanical strength becomes small, there is a defect that a crack and a chip begin to arise, at the time of the work in the case of forming the single crystal thin film which comprises as the main ingredients at least one or more materials selected from a gallium nitride, an indium nitride, and an aluminum nitride on the substrate, as for the thickness of a substrate, it is preferred that it is not less than 0.01 mm, it is more preferred that it is not less than 0.02 mm, and it is still more preferred that it is not less than 0.05 mm.

As mentioned above, when the substrate according to this invention which consists of a sintered compact which comprises an aluminum nitride as the main ingredients is used as a substrate for forming a thin film which comprises as the main ingredients at least one or more materials selected from a gallium nitride, an indium nitride, and an aluminum nitride, it is preferred that the thickness of a substrate is not more than 8 mm, and it is more preferred that it is not more than 5.0 mm, from the viewpoint of an optical permeability (namely, predominance when forming a light emitting device onto the substrate according to this invention which consists of a sintered compact which comprises an aluminum nitride as the main ingredients).

Moreover, it is still more preferred that the thickness of a substrate is not more than 2.5 mm, it is most preferred that the thickness of a substrate is not more than 1.0 mm.

In the substrate of such thickness, it is preferred that it is not less than 0.01 mm from a viewpoint of mechanical strength, it is more preferred that it is not less than 0.02 mm, and it is still more preferred that it is not less than 0.05 mm.

A conduction via can be provided to the substrate for thin film formation according to this invention which consists of a sintered compact which comprises an aluminum nitride as the main ingredients.

The substrate which consists of a sintered compact which comprises an aluminum nitride as the main ingredients in which the conduction via was provided can be equally used, also in order to form a single crystal thin film and to carry out various crystallized states thin film formation.

A conduction via is provided in the inside of the substrate for thin film formation which consists of a sintered compact which usually uses an aluminum nitride as the main ingredients.

This conduction via is formed usually in order to connect electrically the surface of up-and-down (namely, the substrate surface of the side in which the thin film of various crystallized states, such as a single crystal thin film, an amorphous thin film, a polycrystalline thin film, or an orientated polycrystalline thin film, is formed, and the substrate surface of the opposite side of it) of a substrate.

This conduction via can form easily by the suitable methods, for example, a through hole (through hole) is formed in ceramic powder compacts, such as a green sheet which comprises an aluminum nitride as the main ingredients, the conductive powder which comprises a metal etc. as the main ingredients is beforehand put in there, then co-firing is carried out, the substrate which consists of a sintered compact which comprises an aluminum nitride as the main ingredients whose through hole was formed is submerged into a fusion metal, and a fusion metal is introduced into this through hole portion, conductive paste is introduced into the through hole of a substrate, and it heats or fires.

The above-mentioned conduction via can be formed not only in the inside of the sintered compact which comprises an aluminum nitride as the main ingredients but also in the various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and in the other various sintered compacts which comprise a ceramic material as the main ingredients.

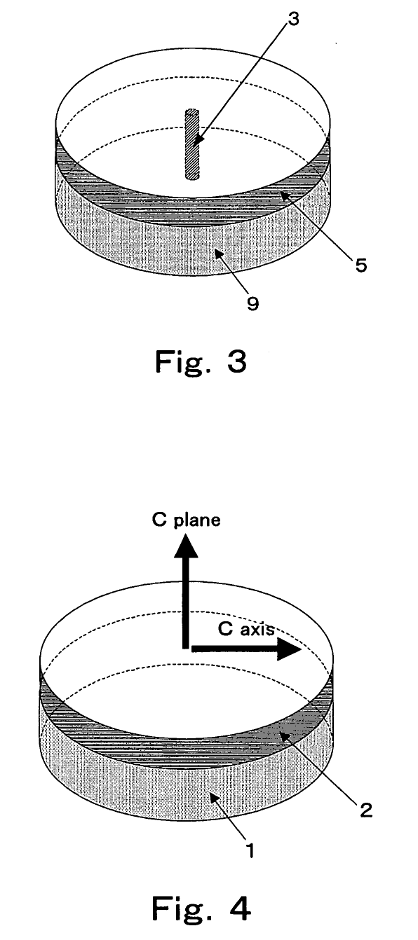

In FIG. 3, the situation of the substrate 9, which has the conduction via 3(the portion shown with the slash) inside and which consists of the sintered compact which comprises an aluminum nitride as the main ingredients, the various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and the other various sintered compacts which comprise a ceramic material as the main ingredients, is illustrated.

The substrate 9 which has this conduction via 3 can be used as a substrate for thin film formation.

On this substrate for thin film formation, the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal can be formed.

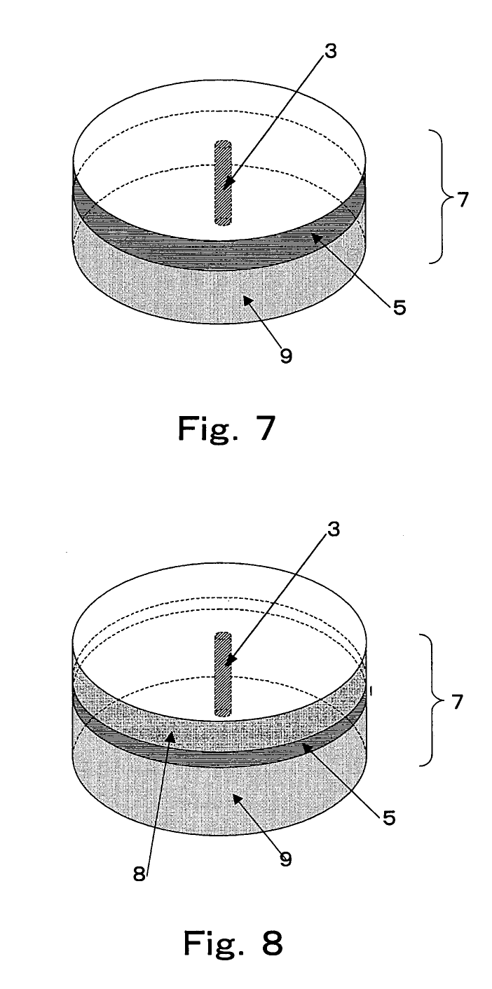

In FIG. 7, one example of a thin film substrate is shown, that is, the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed on the substrate 9 which formed the conduction via 3 and which consists of the sintered compact which comprises an aluminum nitride as the main ingredients, the various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and the other various sintered compacts which comprise a ceramic material as the main ingredients.

In FIG. 7, the substrate 9 which formed the conduction via 3 and which consists of the sintered compact which comprises an aluminum nitride as the main ingredients, the various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and the other various sintered compacts which comprise a ceramic material as the main ingredients are used as a substrate for thin film formation, the thin film 5 which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed on this substrate for thin film formation, and the thin film substrate 7 is being constituted by this substrate 9 and the thin film 5.

The thin film which comprises as the main ingredients at least one or more materials selected from a gallium nitride, an indium nitride, and an aluminum nitride and which is various crystallized states selected from a single crystal, an amorphous state, a polycrystal, and an orientated polycrystal, etc. can form on the sintered compact which comprises an aluminum nitride as the main ingredients, the various sintered compacts which comprise as the main ingredients a ceramic material, such as a silicon carbide, a silicon nitride, a zinc oxide, a beryllium oxide, or an aluminum oxide etc., and the other various sintered compacts which comprise a ceramic material as the main ingredients, (such conduction via was formed in the above sintered compacts), the above-mentioned thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal etc., can form also on the conduction via directly.

Although the thin film 5 currently formed in the thin film substrate which has the conduction via illustrated in FIG. 7 can be formed as an epitaxially grown single crystal thin film, all of this thin film 5 is not only a single crystal but also the thin film which has at least one of the crystallized states selected from an amorphous state, a polycrystal, and an orientated polycrystal can form in addition to this.

What is multilayered thin film constitution of two or more layers can also be formed not only as single layer.

That is, the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed, and the thin film constituted by two layers in which the epitaxially grown single crystal thin film which comprises as the main ingredients at least one or more materials selected from a gallium nitride, an indium nitride, and an aluminum nitride was formed furthermore on it can be formed.

As for the crystallinity, since what is superior to the single crystal thin film which was directly formed on the substrate is easy to be obtained, the single crystal thin film formed in such constitution is preferred.

For example, the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal can be formed, and the thin film of a constitution of which a single crystal is not included can also be formed.

Not only the above-mentioned constitution but the thin film 5 can be formed as a thin film which is constituted with two or more layers which comprise as the main ingredients at least one or more materials selected from a gallium nitride, an indium nitride, and an aluminum nitride. The thin film 5 formed in two or more layers can be formed in the condition of differing respectively in each layer, such as crystallized states, such as an amorphous state, a polycrystal, and an orientated polycrystal, including a single crystal, composition, or thickness, and even if the thin film constitution not all whose two or more-layer thin film layers are single crystals in this invention, it can be formed.

All the thin film layers which are being constituted with a two or more-layer thin film layer can form what consists of a single crystal thin film which comprises as the main ingredients at least one or more materials selected from a gallium nitride, an indium nitride, and an aluminum nitride.

When the thin film substrate according to this invention is used for producing various electronic devices and electronic parts, such as a light emitting device, a field emission display, a wiring board, or an optical waveguide, it is preferred that it is a single crystal which usually grew epitaxially as the thin film formed on the thin film substrate surface.

The thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal can be formed furthermore in the thin film substrate 7 illustrated in FIG. 7.

In that case, this thin film substrate will achieve the facility as a substrate for thin film formation.

One example of a thin film substrate which has the conduction via in which two layers of thin films were formed is shown in FIG. 8.

In FIG. 8, as a substrate for thin film formation, the substrate 9 which formed a conduction via 3 and which consists of the sintered compact which comprises an aluminum nitride as the main ingredients, various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and other various sintered compacts which comprise a ceramic material as the main ingredients is used, the thin film 5 and thin film 8 which comprise as the main ingredients at least one or more materials selected from a gallium nitride, an indium nitride, and an aluminum nitride and which have at least one of the crystallized states selected from a single crystal, an amorphous state, a polycrystal, and an orientated polycrystal are formed in this substrate, thus the thin film substrate 7 which has a conduction via is being formed.

Although the thin film 5 and thin film 8 which are being formed in the thin film substrate illustrated in FIG. 8 can be formed as an epitaxially grown single crystal thin film, these all thin films can form not a single crystal but the thin film which has at least one of the crystallized states selected from an amorphous state, a polycrystal, and an orientated polycrystal in addition to this.

For example, the thin film which comprises as the main ingredients at least one or more materials selected from a gallium nitride, an indium nitride, and an aluminum nitride and which has various crystallized states, such as a single crystal, an amorphous state, a polycrystal, and an orientated polycrystal etc., can be formed, and the thin film of a constitution of that a single crystal is not included can also be formed.

For example, if what comprises as the main ingredients at least one or more materials selected from a gallium nitride, an indium nitride, and an aluminum nitride and has at least one of the crystallized states selected from a single crystal, an amorphous state, a polycrystal, and an orientated polycrystal is formed as a thin film 5, and the epitaxially grown single crystal thin film which comprises as the main ingredients at least one or more materials selected from a gallium nitride, an indium nitride, and an aluminum nitride is formed on it as a thin film 8, since the crystallinity of this thin film 8 tends to improve rather than the crystallinity of the single crystal thin film directly formed on the substrate 9, it is preferred.

The thin film substrate of such thin film constitution is preferred when using it for various electronic devices and for production of electronic parts, such as a light emitting device, field emission, a wiring board, or an optical waveguide.

Not only the above-mentioned constitution but also the thin film 5 and thin film 8 are multilayered into two or more layers, respectively, it can also constitute as a thin film of a total of three or more layers which comprises as the main ingredients at least one or more materials selected from a gallium nitride, an indium nitride, and an aluminum nitride.

The thin film 5 and thin film 8 which were formed in two or more layers, respectively can be formed in the condition of differing, respectively, such as crystallized states, such as an amorphous state, a polycrystal, and an orientated polycrystal, including a single crystal composition, or thickness in each layer, in this invention, it can form, even if it is the constitution of the thin film which comprises as the main ingredients at least one or more materials selected from a gallium nitride, an indium nitride, and an aluminum nitride not all whose thin film layers are single crystals.

Not only the thin film substrate that comprised two layers of thin film layers illustrated in FIG. 8 but what consists of a single crystal thin film with which these all thin film layers comprise as the main ingredients at least one or more materials selected from a gallium nitride, an indium nitride, and an aluminum nitride even if it is the thin film substrate in which three or more layers of thin film layers were formed can be formed. The thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal can be formed furthermore on the thin film substrate 7 illustrated in FIG. 8. In that case, this thin film substrate will achieve the facility as a substrate for thin film formation.

In the thin film substrate illustrated in FIG. 8, the above-mentioned thin film 5 which comprises as the main ingredients at least one or more materials selected from a gallium nitride, an indium nitride, and an aluminum nitride and which has various crystallized states, such as a single crystal, an amorphous state, a polycrystal, and an orientated polycrystal etc., can form on a conduction via 3 directly.

When using the thin film substrate in which two layers or three layers or more of thin films were formed and which was illustrated in FIG. 8, as an object for production of various electronic devices and electronic parts, such as a light emitting device, a field emission display, a wiring board, or an optical waveguide, as for the thin film formed at the surface portion of the thin film substrate, it is preferred that it is usually the single crystal which grew epitaxially.

About the thin film substrate according to this invention which has a conduction via, it is the substrate which formed the thin film which comprises as the main ingredients at least one or more materials selected from a gallium nitride, an indium nitride, and an aluminum nitride onto the substrate which consists of the sintered compact which comprises an aluminum nitride as the main ingredients and which has a conduction via, various sintered compacts which have a conduction via and which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and other various sintered compacts which comprise a ceramic material as the main ingredients and which have a conduction via in addition to these.

As for the thin film formed on the thin film substrate according to this invention which has a conduction via, the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed beforehand, what was more excellent in crystallinity of this single crystal thin film is easy to be obtained with the constitution in which the single crystal thin film which comprises as the main ingredients at least one or more materials selected from a gallium nitride, an indium nitride, and an aluminum nitride was formed furthermore on it if it requires, it is desirable.

Although the form of a substrate of having the conduction via shown in FIG. 3, FIG. 7, and FIG. 8 is disc-like, in this invention, the form of the substrate which formed inside the conduction via which can be used can use what has arbitrary form, such as not only the shape of a disk-like but a square, a rectangle, or the shape of other polygons.

Although only one piece is shown in FIG. 3, FIG. 7, and FIG. 8 as for the conduction via, into a substrate, two or more conduction vias can be provided suitably.

For example, since the size of one piece of a light emitting device which comprises as the constituent ingredient a single crystal thin film which comprises as the main ingredients at least one or more materials selected from a gallium nitride, an indium nitride, and an aluminum nitride is about 0.05-10.0 mm, in a disc-like substrate with a diameter of 25.4 mm, about 2-10000 conduction vias can be provided in consideration of an edge left for dicing.

After forming a light emitting device on the substrate which has this conduction via, the light emitting device which has PN electrode arrangement can be formed in the up-and-down side of a device by separating one piece of a light emitting device at a time from a substrate.

Such a light emitting device in which the electrode of up-and-down side arrangement is formed differs from that by which PN electrode was formed only in one side of a device when a sapphire substrate is used, it is not necessary to etch a part of device in order to form an electrode, since it can be made as a device as it is only by separating from a substrate there is no fear of the damage of the device which is easy to produce during etching, and reduction of the manufacture cost of a device can be aimed at, it is desirable.

Moreover, if the substrate by this invention which formed a conduction via is used, there is the feature that flexibility of a design also improves because the device in which the PN electrode is attached not only in one side of a device but also in the up-and-down side of a device can be designed.

As for the conductive material used for a conduction via, if it is the thing which is easy to unite with the sintered compact which comprises an aluminum nitride as the main ingredients, various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and other various sintered compacts which comprise a ceramic material as the main ingredients, and which has high junction nature with the thin film which comprises as the main ingredients at least one or more materials selected from a gallium nitride, an indium nitride, and an aluminum nitride, and if faults, such as a crack and exfoliation in the interface with a conduction via, do not arise when forming this thin film to a conduction via, and it requires further, connectability with a thin film is electrically high, anything can be used.

Such material comprises as the main ingredients at least one or more elements selected from gold, silver, copper, aluminum, iron, cobalt, nickel, ruthenium, rhodium, palladium, osmium, iridium, platinum, tungsten, molybdenum, chromium, titanium, a titanium nitride, a zirconium nitride, etc.

As for the conduction via which consists of such material has high junction nature with the thin film, not only it is easy to unite with the substrate material which consists of the above-mentioned sintered compact which comprises an aluminum nitride as the main ingredients, various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and other various sintered compacts which comprise a ceramic material as the main ingredients, but also the junction nature with the thin film formed in a substrate is high, the thin film which comprises as the main ingredients at least one or more materials selected from a gallium nitride, an indium nitride, and an aluminum nitride can be formed directly in a conduction via.

The conduction via which consists of the above-mentioned material has also high electrical connectability with the thin film which comprises as the main ingredients at least one or more materials selected from a gallium nitride, an indium nitride, and an aluminum nitride.

Usually, as for the single crystal thin film formed directly on the conduction via which consists of the above-mentioned material, what is the crystallinity, such that the half width of the rocking curve of the X-ray diffraction line from the lattice plane of a Miller Index (002) is not more than 3600 seconds, is easy to be obtained.

As for what added at least one or more ingredients selected from an aluminum nitride, a silicon carbide, a silicon nitride, a zinc oxide, a beryllium oxide, an aluminum oxide, a rare-earth compound, an alkaline earth metal compound, etc. to the above-mentioned main ingredients as a material of the conduction via, not only it is easy to nunite the substrate materials including an aluminum nitride sintered compact, but also it has still higher junction nature with the thin film formed on a substrate and it can directly form a single crystal thin film which comprises as the main ingredients at least one or more materials selected from a gallium nitride, an indium nitride, and an aluminum nitride, on a conduction via, as for the crystallinity, the thing, such that the half width of the rocking curve of the X-ray diffraction line from the lattice plane of a Miller Index (002) of this single crystal thin film is not more than 1000 seconds, is easy to be obtained.

The conduction via which consists of the above-mentioned material has also high electrical connectability with the thin film which comprises as the main ingredients at least one or more materials selected from a gallium nitride, an indium nitride, and an aluminum nitride.

In the material of the above-mentioned conduction via, what comprises as the main ingredients at least one or more elements selected from molybdenum, tungsten, copper, titanium nitride, and zirconium nitride not only is easy to combine with the materials including the aluminum nitride sintered compact of a substrate but also can form the single crystal thin film which comprises as the main ingredients at least one or more materials selected from a gallium nitride, an indium nitride, and an aluminum nitride to the conduction via via the thin film formed in a substrate or directly, since the thing of crystallinity not more than 300 seconds as half width of the rocking curve of the X-ray diffraction line from the lattice plane of a Miller Index (002) of this single crystal thin film is easy to be obtained, it is more desirable.

As for the thing which comprises as the main ingredients at least one or more ingredients selected from molybdenum, tungsten, copper, titanium nitride, and zirconium nitride and contains further at least one or more ingredients selected from an aluminum nitride, an aluminum oxide, a rare-earth compound, and a alkaline earth metal compound, not only it is easy to combine with the materials including the aluminum nitride sintered compact of a substrate but also it can form the single crystal thin film which comprises as the main ingredients at least one or more materials selected from a gallium nitride, an indium nitride, and an aluminum nitride to the conduction via via the thin film formed on a substrate or to a conduction via directly, as for the crystallinity, since the thing, such that the half width of the rocking curve of the X-ray diffraction line from the lattice plane of a Miller Index (002) of this single crystal thin film is not more than 240 seconds, is easy to be obtained, it is still more desirable.

As for the content of at least one or more ingredients selected from an aluminum nitride, an aluminum oxide, a rare-earth compound, and an alkaline earth metal compound which are contained in the material which forms this conduction via, it is preferred that it is a total of not more than 30 weight %, the specific resistance in room temperature of the conduction via constituted by the above-mentioned material becomes not more than 1×10⁻³ Ω·cm.

If it is more than 30 weight %, since the specific resistance of the conduction via constituted by the above-mentioned material will tend to become higher than 1×10⁻³ Ω·cm in room temperature, it is not desirable.

More desirable content is not more than 10 weight %, and since the specific resistance of the conduction via constituted by the above-mentioned material tends to become not more than 1×10⁻⁴ Ω·cm in the room temperature, it is more preferred.

Still more desirable content is not more than 5 weight %, and since the specific resistance of the conduction via constituted by the above-mentioned material tends to become not more than 1×10⁻⁵ Ω·cm in the room temperature, it is more preferred.

The molybdenum and tungsten which are used as the main ingredients of the above-mentioned conduction via can be used also as not only a metal but carbide, or nitride.

Thus, as for the thing which comprises as the main ingredients at least one or more elements selected from molybdenum, tungsten, copper, titanium nitride, and zirconium nitride, or the thing which comprises as the main ingredients at least one or more ingredients selected from molybdenum, tungsten, copper, titanium nitride, and zirconium nitride and contains further at least one or more ingredients selected from an aluminum nitride, an aluminum oxide, a rare-earth compound, and a alkaline earth metal compound in the material of a conduction via, the reason of having high crystallinity of the single crystal thin film which comprises as the main ingredients at least one or more materials selected from a gallium nitride, an indium nitride, and an aluminum nitride which was formed on a conduction via via the thin film formed on a substrate or formed on the conduction via directly is not necessarily clear.

This inventor surmises that it is hard to produce the large strain and the stress in this single crystal thin film that grew epitaxially since the thermal expansion coefficient of the above-mentioned material that comprises as the main ingredients at least one or more elements selected from molybdenum, tungsten, copper, titanium nitride, and zirconium nitride is comparatively small and is probably close to the sintered compact which comprises an aluminum nitride as the main ingredients, and it is close to the thermal expansion coefficient of the single crystal thin film which comprises as the main ingredients at least one or more materials selected from a gallium nitride, an indium nitride, and an aluminum nitride, or it was elasticity comparatively in the case of copper, and surmises that when the thin film which comprises as the main ingredients at least one or more materials selected from a gallium nitride, an indium nitride, and an aluminum nitride is formed on the conduction via, the sintered compact which comprises an aluminum nitride as the main ingredients works so that single crystal-ization of this thin film may not be prevented near a conduction via.

The rare-earth compound used for the above-mentioned conduction via is a rare earth element, such as Sc, Y, La, Ce, Pr, Nd, Sm, Eu, Gd, Dy, Ho, Er, Yb, and Lu, etc., and a rare earth oxide, such as Sc₂O₃, Y₂O₃, La₂O₃, CeO₂ and Pr₆O₁₁, Nd₂O₃, Sm₂O₃, Eu₂O₃, Gd₂O₃, Dy₂O₃, Ho₂O₃, Er₂O₃, Yb₂O₃, and Lu₂O₃, etc., or in addition to this, various rare earth compounds, such as inorganic rare earth compounds, such as carbonate, nitrate, sulfate, and a chloride, and organic rare earth compounds, such as acetate, an oxalate, and citrate, which contains Sc, Y, La, Ce, Pr, Nd, Sm, Eu, Gd, Dy, Ho, Er, Yb, Lu, etc., and 3Ln₂O₃.5Al₂O₃ of a garnet type crystal structure (for example, 3Y₂O₃.5Al₂O₃, 3Dy₂O₃.5Al₂O₃, 3Ho₂O₃.5Al₂O₃, 3Er₂O₃.5Al₂O₃, 3Yb₂O₃.5Al₂₀₃, etc.), Ln₂O₃.Al₂O₃ of a perovskite type crystal structure (for example, YAlO₃, LaAlO₃, PrAlO₃, NdAlO₃, SmAlO₃, EuAlO₃, GdAlO₃, DyAlO₃, HoAlO₃, ErAlO₃, YbAlO₃, etc.) and monoclinic system crystal structure 2Ln₂O₃.Al₂O₃ (for example, 2Y₂O₃.Al₂O₃, 2Sm₂O₃.Al₂O₃, 2Eu₂O₃.Al₂O₃, 2Gd₂O₃.Al₂O₃, 2Dy₂O₃.Al₂O₃, 2Ho₂O₃.Al₂O₃, 2Er₂O₃.Al₂O₃, 2Yb₂O₃.Al₂O₃, etc.), when a rare earth element is expressed with Ln.

The alkaline earth metal compound which is used for the above-mentioned conduction via is an alkaline earth metal, such as Mg, Ca, Sr, and Ba, etc., and an alkaline earth metal oxide, such as MgO, CaO, SrO, and BaO, etc., or in addition, various alkaline earth metal compounds, such as an inorganic alkaline earth metal compound, such as carbonate, nitrate, sulfate, and chloride, and an organic alkaline earth metal compound, such as acetate, oxalate, and citrate which contain Mg, Ca, Sr, and Ba, etc., and a complex oxide which includes an alkaline earth metal, such as 3AeO.Al₂O₃, Ae.Al₂O₃, Ae.2Al₂O₃, and Ae.6Al₂O₃, etc., when an alkaline earth metal element is expressed with Ae.

In this invention, also in each material used for a conduction via other than the thing which comprises as the main ingredients at least one or more ingredients selected from the above-mentioned molybdenum, tungsten, copper, titanium nitride, and zirconium nitride and contains further at least one or more ingredients selected from an aluminum nitride, an aluminum oxide, a rare-earth compound, and an alkaline earth metal compound, it is preferred if the specific resistance in room temperature has the conductivity of not more than 1×10⁻³ Ω·cm, it is more preferred that the specific resistance in room temperature is not more than 1×10⁻⁴ Ω·cm, it is still more preferred that the specific resistance in room temperature is not more than 1×10⁻⁵ Ω·cm.

In this invention, if the substrate in which the above-mentioned conduction via is formed is the sintered compact which comprises an aluminum nitride as the main ingredients, it may be what contains at least one or more materials of a sintering aids, a firing temperature reduction-ized agent, a black-ized agent, an unescapable impurity, ALON, etc., it may be what contains AlN not less than 95% as a crystal phase by purification, or what contains AlN not less than 98%, or what consists of an AlN single phase substantially, any sintered compact which comprises an aluminum nitride as the main ingredients can be used.

As for the material of the conduction via formed in the sintered compact which comprises an aluminum nitride as the main ingredients, if it is used the thing which comprises as the main ingredients at least one or more ingredients selected from molybdenum, tungsten, copper, titanium nitride, and zirconium nitrides, or the thing which comprises as the main ingredients at least one or more ingredients selected from molybdenum, tungsten, copper, titanium nitride, and zirconium nitride and contains further at least one or more ingredients selected from an aluminum nitride, an aluminum oxide, a rare-earth compound, and an alkaline earth metal compound, since it hardly vaporizes also during the high temperature and prolonged heat treatment performed in order to carry out high purification of the sintered compact which comprises an aluminum nitride as the main ingredients and to raise optical transmissivity, manufacture of the substrate which has a conduction via is attained easily, the outstanding substrate which has high thermal conductivity and optical permeability and can connect the up-and-down side of a substrate and whose thermal expansion coefficient is close to the single crystal thin film comprising at least one or more materials selected from a gallium nitride, an indium nitride, and an aluminum nitride as the main ingredients, can provide in low cost, the influence which gives to the industrial world is still larger.

In this invention, the magnitude and form of a conduction via can be selected suitably, even if it is the thing of what kind of magnitude, what is necessary is to be able to form a thin film which comprises as the main ingredients a gallium nitride, an indium nitride, and an aluminum nitride directly and just to be able to form a single crystal thin film if needed.

And the form can also choose anything, what is necessary is to be able to form a thin film which comprises as the main ingredients a gallium nitride, an indium nitride, and an aluminum nitride directly and just to be able to form a single crystal thin film if needed.

Usually, even if the size of a conduction via is larger than 250 μm, the single crystal thin film which comprises as the main ingredients at least one or more materials selected from a gallium nitride, an indium nitride, and an aluminum nitride can form to this conduction via directly.

That is, even when the size of a conduction via is larger than 250 μm, as for the single crystal thin film which comprises as the main ingredients at least one or more materials selected from a gallium nitride, an indium nitride, and an aluminum nitride directly formed in a conduction via, the thing of crystallinity not more than 3600 seconds as half width of the rocking curve of the X-ray diffraction line from the lattice plane of a Miller Index (002) of this crystal thin film is easy to be obtained.

For example, even if the size of a conduction via is comparatively large, such as 500 μm, as for the single crystal thin film which comprises as the main ingredients at least one or more materials selected from a gallium nitride, an indium nitride, and an aluminum nitride and is formed on this conduction via, the single crystal thin film which has the crystallinity not more than 3600 seconds as half width of the rocking curve of the X-ray diffraction from the lattice plane of a Miller Index (002) can be obtained.

Usually, as for the size of a conduction via, it is preferred that it is not more than 250 μm.

If the size of a conduction via is not more than 250 μm, the thing excellent in crystallinity, such that the half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and was formed directly on the conduction via is not more than 300 seconds, will be easy to be obtained.

The preferable size of a conduction via is not more than 100 μm.

If the size of a conduction via is not more than 100 μm, the thing more excellent in crystallinity, such that the half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and was formed directly on the conduction via is not more than 240 seconds, will be easy to be obtained.

It is still more preferable that it is not more than 50 μm.

If the size of a conduction via is not more than 50 μm, the thing still more excellent in crystallinity, such that the half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and was formed directly on the conduction via is not more than 200 seconds, will be easy to be obtained.

It is still more preferable that it is not more than 25 μm.

If the size of a conduction via is not more than 25 μm, the thing still more excellent in crystallinity, such that the half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and was formed directly on the conduction via is not more than 150 seconds, will be easy to be obtained.

Since a conduction via is a material which differs from the aluminum nitride which is the main ingredients of a substrate, it is easy to produce a difference in the crystallinity of the single crystal thin film which comprises as the main ingredients at least one or more materials selected from a gallium nitride, an indium nitride, and an aluminum nitride and is formed on a substrate by the size of a conduction via, it is surmised that it will be because a difference generates in the degree which makes the nuclear growth direction regular at the time of growth of the single crystal thin film which comprises as the main ingredients at least one or more materials selected from a gallium nitride, an indium nitride, and an aluminum nitride by the magnitude.

This invention is indicated to be the size of a conduction via with the upper limit of a cross section.

That is, when a cross section is the form of a circle with the diameter of 200 μm, the size of a conduction via is 200 μm as it is, and in the case of one-side 150 μm square, the size of a conduction via is 212 μm.

A conduction via can use arbitrary cross section form, it is preferably to use what has a circular cross section from a point of workability, with such form, the single crystal thin film which comprises as the main ingredients at least one or more materials selected from a gallium nitride, an indium nitride, and an aluminum nitride can form.

In order to form a conduction via, the laser processing method by carbon dioxide gas laser, YAG laser or an excimer laser, etc., for example, is preferred as a fine drilling processing method in addition to the punching method using the needle usually performed as a method of forming a through hole in ceramic powder compacts, such as a green sheet which comprises an aluminum nitride as the main ingredients as mentioned above.

The above-mentioned laser processing method is suitable also for the punch to the sintered compact after firing.

The conduction via of not more than 50 μm and up to about 1 μm can be formed by using the laser processing method.

As the size of the conduction via formed in the sintered compact which comprises an aluminum nitride as the main ingredients and is obtained by firing a green sheet becomes still smaller from 50 μm and 1 μm is approached, the thing excellent in crystallinity, such that the half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and was formed directly on the conduction via is not more than 150 seconds considered that the sintered compact which comprises an aluminum nitride as the main ingredients originally has, will be easy to be obtained, it is desirable especially.

In this invention, what is various forms can be used as the form of a conduction via, such as that with which the conductive material was densely filled up in the through hole, or what formed the conductive material in the side wall of a through hole.

In these, a having-so-called form of filling via formed in dense condition with conductive material in through hole thing is preferred, there is an advantage which the single crystal thin film which comprises as the main ingredients at least one or more materials selected from a gallium nitride, an indium nitride, and an aluminum nitride can form easily.

Since it can connect electrically the surface and the back of the substrate for thin film formation which consists of a sintered compact which is an insulating material electrically originally and comprises an aluminum nitride as the main ingredients by providing a conduction via, the electrode of an element can be provided to an up-and-down side.

When not providing a conduction via, although the electrode of a light emitting device is provided only at the surface only by the side of the light emitting device formed on the substrate, the degree of freedom in the case of mounting a light emitting device in a substrate by forming a conduction via increases, and it becomes advantageous.

This inventor considered thin film formation which comprises as the main ingredients at least one or more materials selected from a gallium nitride, an indium nitride, and an aluminum nitride to the sintered compact which comprises an aluminum nitride as the main ingredients in which the thin film which has the conductivity and which comprises as the main ingredients materials, such as various metals, an alloy, metal nitride, metallic carbide, and metal silicide, was formed.

As a result, it became clear that the sintered compact which comprises an aluminum nitride as the main ingredients and in which the thin film conductivity material which comprises as the main ingredients the various above-mentioned metals, an alloy, metal nitride, metal carbide, and metal silicide, etc. was formed can be used as a substrate for thin film formation on a par with the sintered compact which comprises an aluminum nitride as the main ingredients in which this thin film conductivity material is not formed.

As for such thin film conductivity material, anything can be used, if junction nature with the sintered compact which comprises an aluminum nitride as the main ingredients is highly, and junction nature with the thin film which comprises as the main ingredients at least one or more materials selected from a gallium nitride, an indium nitride, and an aluminum nitride is highly, and if it furthermore requires, what has high connectability electrically, or what has a high light reflectance.

Namely, for example, using the conductive material which comprises as the main ingredients at least one or more elements selected from gold, silver, copper, aluminum, iron, cobalt, nickel, ruthenium, rhodium, palladium, osmium, iridium, platinum, tantalum, molybdenum, tungsten, chromium, titanium, nickel chromium alloy, titanium nitride, zirconium nitride, and tantalum nitride, etc., by the methods using sputtering, ion-plating, vapor deposition, an MOCVD (Metal Organic Chemical Vapor Deposition) method, an MOVPE (Metal Organic Vapor Phase Epitaxy) method, a Hydride VPE (Hydride Vapor Phase Epitaxy) method, a Chloride VPE (Chloride Vapor Phase Epitaxy) method, a Plasma CVD method, other CVD (Chemical Vapor Deposition) method, and an MBE (Molecular Beam Epitaxy) method, or the laser ablation method by using such as excimer laser, and the PLD (pulsed-laser deposition: pulsed laser decomposition) method, by making the raw material the material which consists of various compounds, such as an organic compound, an inorganic compound, and a nitride, a metal, an alloy, etc., which contain the purpose ingredient, by forming the thin film which comprises this conductive material as the main ingredients onto the sintered compact which comprises an aluminum nitride as the main ingredients according to this invention, a thin film conductivity material is obtained, the thin film which comprises as the main ingredients at least one or more materials selected from a gallium nitride, an indium nitride, and an aluminum nitride can be formed on this thin film conductivity material.

Usually, the above-mentioned thin film conductivity material is formed on the surface of a sintered compact which comprises an aluminum nitride as the main ingredients.

The thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal can be formed on the sintered compact which comprises an aluminum nitride as the main ingredients and which formed the above-mentioned thin film conductivity material by choosing the thin film forming conditions suitably.

As conditions for a Sputtering method, the conductive material which comprises as the main ingredients at least one or more materials selected from the above-mentioned gold, silver, copper, aluminum, iron, cobalt, nickel, ruthenium, rhodium, palladium, osmium, iridium, platinum, tantalum, molybdenum, tungsten, chromium, titanium, nickel chromium alloy, titanium nitride, zirconium nitride, and tantalum nitride, etc. is used as a target, substrate temperature is suitably made into room temperature—300 degrees C., and further more substrate temperature is suitably made into not less than 300 degrees C., thin film is formed, for example, by passing Ar gas by the flow rate of 10-200 cc/min. with the pressure of 0.2-2.0 Pa under decompression, and applying 0.3-3 kW direct current power or high-frequency power.

As for the frequency of radio frequency (RF) electric power, 2.45 GHz microwave or a 13.56 MHz radiofrequency wave is usually used.

When thin film conductivity materials are metallic compounds, such as titanium nitride, zirconium nitride, and tantalum nitride, reactant gas, such as N₂ gas and NH₃ gas, is suitably used alone as a controlled atmosphere, for example, or it is also effective to use in addition to carrier gas, such as Ar gas and H₂ gas, and to form this thin film conductivity material by reactive sputtering.

As the conditions for an Ion-plating method, the conductive material which comprises as the main ingredients at least one or more materials selected from the above-mentioned gold, silver, copper, aluminum, iron, cobalt, nickel, ruthenium, rhodium, palladium, osmium, iridium, platinum, tantalum, molybdenum, tungsten, chromium, titanium, and nickel chromium alloy, etc. is used as a fusion raw material, substrate temperature is suitably made into room temperature—300 degrees C., or substrate temperature is suitably made into not less than 300 degrees C., and thin film formation is performed for the degree of vacuum of not more than 2×10⁻³ Pa in a thin film formation chamber with ionizing voltage 10-200V and the applied voltage 300-5000V to a substrate.

Or it can also carry out, using high frequency as applied electric power.

As for the frequency of radio frequency (RF) electric power, 2.45 GHz microwave or 13.56 etc.MHz are usually used.

When thin film conductivity materials are metallic compounds, such as titanium nitride, zirconium nitride, and tantalum nitride, reactant gas, such as N₂ gas and NH₃ gas, is suitably used alone, for example, or it is also effective to use in addition to carrier gas, such as Ar gas and H₂ gas, and to form this thin film conductivity material by reactive Ion-plating method using metal, such as titanium, a zirconium, and tantalum, for fusion material.

As the conditions for a vacuum deposition method, the conductive material which comprises as the main ingredients at least one or more materials selected from the above-mentioned gold, silver, copper, aluminum, iron, cobalt, nickel, ruthenium, rhodium, palladium, osmium, iridium, platinum, tantalum, molybdenum, tungsten, chromium, titanium, and nickel chromium alloy, etc. is used as a fusion raw material, substrate temperature is suitably made into room temperature—300 degrees C., furthermore substrate temperature is suitably made into not less than 300 degrees C., and thin film formation is performed for the degree of vacuum of not more than 2×10⁻³ Pa in a thin film formation chamber.

The above-mentioned Sputtering method, an Ion-plating method, or Vacuum deposition is not only used only for formation of a thin film conductivity material, like an MOCVD method, a Chloride VPE method, a Halide VPE method, a Hydrides VPE method, or an MBE method, it can use also as a method of forming the thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal etc., by this invention, and it can use as a method of forming the thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal etc., containing doping ingredients, such as Si, Ge, Se, Te, O, Mg, Be, Ca, Zn, Cd, and C, etc.

When performing these thin film formations, in a Sputtering method by using the target which comprises as the main ingredients a gallium nitride, an indium nitride, and an aluminum nitride, the thin film which comprises as the main ingredients a gallium nitride, an indium nitride, and an aluminum nitride of the target composition is obtained, or by using metal gallium, metal indium, and metal aluminum as a target, and by making it react with the above-mentioned N₂ gas, NH₃ gas, etc, the thin film which comprises as the main ingredients a gallium nitride, an indium nitride, and an aluminum nitride of the target composition can be obtained.

In an Ion-plating method and Vacuum deposition, the thin film which comprises as the main ingredients a gallium nitride, an indium nitride, and an aluminum nitride of the target composition can be obtained according to making it react with the above-mentioned N₂ gas, NH₃ gas, etc., using metal gallium, metal indium, and metal aluminum as a target.

A crack is not seen in the thin film which comprises as the main ingredients at least one or more materials selected from a gallium nitride, an indium nitride, and an aluminum nitride and was formed on the sintered compact which has a thin film conductivity material and comprises an aluminum nitride as the main ingredients, but faults, such as exfoliation, are hard to see between this thin film conductivity material and the thin film which comprises as the main ingredients at least one or more materials selected from a gallium nitride, an indium nitride, and an aluminum nitride.

When the thin film which comprises the above-mentioned conductive material as the main ingredients is formed on the sintered compact which comprises an aluminum nitride as the main ingredients and the single crystal thin film which comprises as the main ingredients at least one or more materials selected from a gallium nitride, an indium nitride, and an aluminum nitride is formed furthermore on it, what is the crystallinity, such that the half width of the rocking curve of the X-ray diffraction line from the lattice plane of the Miller Index (002) of the single crystal thin film is not more than 3600 seconds, is easy to be obtained.

Since junction nature with the thin film which comprises as the main ingredients at least one or more materials selected from a gallium nitride, an indium nitride, and an aluminum nitride is also high and what is not less than 2 Kg/mm² is easy to be obtained as perpendicular tensile strength, it is desirable.

Even if it tests by pasting up and tearing off pressure sensitive adhesive tape to the thin film which comprises as the main ingredients at least one or more materials selected from a gallium nitride, an indium nitride, and an aluminum nitride which formed on the sintered compact which has the above-mentioned thin film conductivity material and comprises an aluminum nitride as the main ingredients, exfoliation is not seen between the thin films which comprise as the main ingredients at least one or more materials selected from a gallium nitride, an indium nitride, and an aluminum nitride and this thin film conductivity material.

The above-mentioned junction nature can be similarly obtained, even if the thin films which comprise as the main ingredients at least one or more materials selected from a gallium nitride, an indium nitride, and an aluminum nitride are what kind of crystallized states, such as a single crystal, an amorphous state, a polycrystal, and an orientated polycrystal.

Thus, the thin film conductivity material by this invention has high junction nature between the thin films which comprise as the main ingredients at least one or more materials selected from a gallium nitride, an indium nitride, and an aluminum nitride, from the result of the above-mentioned junction nature appraisal method, it seems that the thin film conductivity material by this invention has junction nature of not less than 2 Kg/mm² which is equivalent at least to a thin film as perpendicular tension strength to the sintered compact which comprises an aluminum nitride as the main ingredients.

Usually, using the above-mentioned thin film conductivity material whose thickness is not more than 20 μm is preferred, in order to raise the quality of the thin film which comprises as the main ingredients at least one or more materials selected from a gallium nitride, an indium nitride, and an aluminum nitride and is formed on it and to raise junction nature with this thin film.

That is, if the thickness of the above-mentioned thin film conductivity material is not more than 20 μm, as the single crystal thin film which comprises as the main ingredients at least one or more materials selected from a gallium nitride, an indium nitride, and an aluminum nitride and formed on this thin film conductivity material, the single crystal thin film which has the crystallinity, such that the half width of the rocking curve of the X-ray diffraction line from the lattice plane of a Miller Index (002) is not more than 300 seconds, is easy to be obtained, even if these thin films are crystallized states which are not necessarily single crystal, such as an amorphous state and a polycrystal, since what is not less than 2 Kg/mm² of a perpendicular tensile strength is easy to be obtained as junction nature with this thin film, it is more desirable.

If the thickness of the above-mentioned thin film conductivity material is not more than 5 μm, as for the single crystal thin film which comprises as the main ingredients at least one or more materials selected from a gallium nitride, an indium nitride, and an aluminum nitride and was formed on this thin film conductivity material, the single crystal thin film which has the crystallinity, such that the half width of the rocking curve of the X-ray diffraction line from the lattice plane of a Miller Index (002) is not more than 240 seconds, is easy to be obtained, even if these thin films are crystallized states which are not necessarily single crystal, such as an amorphous state and a polycrystal, since what is not less than 2 Kg/mm² of a perpendicular tensile strength is easy to be obtained as junction nature with this thin film, it is more desirable.

If the thickness of the above-mentioned thin film conductivity material is not more than 1 sum, as for the single crystal thin film which comprises as the main ingredients at least one or more materials selected from a gallium nitride, an indium nitride, and an aluminum nitride and was formed on this thin film conductivity material, the single crystal thin film which has the crystallinity, such that the half width of the rocking curve of the X-ray diffraction line from the lattice plane of a Miller Index (002) is not more than 200 seconds, is easy to be obtained, even if these thin films are crystallized states which are not necessarily single crystals, such as an amorphous state and a polycrystal, since what is not less than 2 Kg/mm² of a perpendicular tensile strength is easy to be obtained as junction nature with this thin film, it is more desirable.

As for the above-mentioned result, it was confirmed that the thin film substrate in which the thin film which comprises as the main ingredients at least one or more materials selected from a gallium nitride, an indium nitride, and an aluminum nitride was formed on the sintered compact which comprises an aluminum nitride as the main ingredients and which formed the thin film conductivity material can be manufactured.

Moreover, the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal can form further on the substrate which formed the above-mentioned thin film conductivity material and which consists of the various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and other various sintered compacts which comprise a ceramic material as the main ingredients.

This thin film can be formed as a two or more-layer thin film layer from which a crystallized state, composition, etc. differ not only as single layer.

In the substrate which consists of a sintered compact which comprises an aluminum nitride as the main ingredients and which currently forms a thin film conductivity material, an epitaxially grown single crystal thin film which comprises as the main ingredients at least one or more materials selected from a gallium nitride, an indium nitride, and an aluminum nitride can be formed, in addition, the thin film which has at least one of crystallized states selected from amorphous state, polycrystal, and orientated polycrystal and which is not a single crystal can also be formed.

What is the multilayered thin film constitution of two or more layers can also be formed not only as single layer.

That is, the thin film which comprises as the main ingredients at least one or more materials selected from a gallium nitride, an indium nitride, and an aluminum nitride and which consists of at least one of the crystallized states selected from a single crystal, an amorphous state, a polycrystal, and an orientated polycrystal is formed beforehand, the thin film of 2 layers constitution with which the epitaxially grown single crystal thin film which comprises as the main ingredients at least one or more materials selected from a gallium nitride, an indium nitride, and an aluminum nitride was formed on it can be formed.

As for the crystallinity of the single crystal thin film formed in such constitution, what is superior to the single crystal thin film directly formed on the substrate which consists of a sintered compact which comprises an aluminum nitride as the main ingredients and which formed the thin film conductivity material is easy to be obtained, it is preferred.

For example, the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed, the thin film of two layers constitution in which the thin film which consists of at least one of the crystallized states selected from an amorphous state, a polycrystal, and an orientated polycrystal and which does not contain a single crystal was formed can also be formed on it.

The thin film formed in two or more layers can be formed in different condition in each layer, respectively, such as crystallized states, such as including a single crystal, an amorphous state, a polycrystal, and an orientated polycrystal, a composition, or a thickness, and even if all the two or more-layer thin film layers are the thin film constitution which is not single crystals in this invention, it can be formed in this invention.

All the thin film layers which are being constituted with a two or more-layer thin film layer can form what consists of a single crystal thin film which comprises as the main ingredients at least one or more materials selected from a gallium nitride, an indium nitride, and an aluminum nitride.

As for at least one or more layers among the thin film layers which are being constituted with two or more layers, and if it requires, as for a surface thin film layer, it is preferred that it is a single crystal.

Especially, when the thin film substrate by which the thin film which comprises as the main ingredients at least one or more materials selected from a gallium nitride, an indium nitride, and an aluminum nitride was formed on the substrate on which the thin film conductivity material was formed beforehand by this invention is used for production of various electronic devices, such as a light emitting device, a field emission display, a wiring board, or an optical waveguide, and electronic parts etc., as for the thin film formed at the surface portion of the substrate, it is preferred that it is the single crystal which usually grew epitaxially.

In this invention, the above-mentioned thin film conductivity material can be formed also on the thin film substrate in which the thin film which comprises as the main ingredients at least one or more materials selected from a gallium nitride, an indium nitride, and an aluminum nitride was formed on the sintered compact which comprises an aluminum nitride as the main ingredients.

That is, the above-mentioned thin film conductivity material can be formed on the thin film which comprises as the main ingredients at least one or more materials selected from a gallium nitride, an indium nitride, and an aluminum nitride which was currently formed beforehand on the sintered compact which comprises an aluminum nitride as the main ingredients, and has sufficient junction nature.

A crack is not seen in the thin film which comprises as the main ingredients at least one or more materials selected from a gallium nitride, an indium nitride, and an aluminum nitride in which the above-mentioned thin film conductivity material was formed, but faults, such as exfoliation, are hard to see between this thin film which comprise as the main ingredients at least one or more materials selected from a gallium nitride, an indium nitride, and an aluminum nitride and the above-mentioned thin film conductivity material.

What has not less than 2 Kg/mm² of bonding strength by a perpendicular tensile test is easy to obtain.

As a reason such good junction nature is obtained, this inventor is surmising that it is a big factor that since the thin film which comprises as the main ingredients at least one or more materials selected from a gallium nitride, an indium nitride, and an aluminum nitride is being formed on the sintered compact which comprises an aluminum nitride as the main ingredients, there is little internal stress by the lattice mismatching, or the difference of thermal expansion coefficient, etc.,

moreover, distortion and tensile stress produced when a thin film conductivity material is formed is easy to be produced numerously not in this thin film that is a brittle material but in a thin film conductivity material that is comparatively soft or has a larger thermal expansion coefficient or is easy to be produced only in a thin film conductivity material.

The above-mentioned junction nature can be similarly acquired, even if thin films which comprise as the main ingredients at least one or more materials selected from a gallium nitride, an indium nitride, and an aluminum nitride are what kind of crystallized states, such as a single crystal, an amorphous state, a polycrystal, and an orientated polycrystal.

The material which can be soldered is formed like gold or copper among the above-mentioned thin film conductivity materials, if bonding strength is measured using solde, what has not less than 4 Kg/mm² of the perpendicular tensile strength will be easy to be obtained.

This shows that not only the junction between the thin film conductivity material according to this invention and the thin film which comprises as the main ingredients at least one or more materials selected from a gallium nitride, an indium nitride, and an aluminum nitride is high, but also the junction nature between the sintered compact which comprises an aluminum nitride as the main ingredients and thin film conductivity material, and the junction nature between the sintered compact which comprises an aluminum nitride as the main ingredients and the thin film which comprises as the main ingredients at least one or more materials selected from a gallium nitride, an indium nitride, and an aluminum nitride are originally high.

The above-mentioned thin film conductivity material by this invention can form not only at the surface of the thin film which comprises as the main ingredients at least one or more materials selected from a gallium nitride, an indium nitride, and an aluminum nitride but also in the inside of this thin film.

That is, a thin film conductivity material is formed to the thin film which comprises as the main ingredients at least one or more materials selected from a gallium nitride, an indium nitride, and an aluminum nitride currently formed beforehand on the sintered compact which comprises an aluminum nitride as the main ingredients, if a thin film conductivity material is formed in the inside of the thin film which comprises as the main ingredients at least one or more materials selected from a gallium nitride, an indium nitride, and an aluminum nitride by covering furthermore with the thin film which comprises as the main ingredients at least one or more materials selected from a gallium nitride, an indium nitride, and an aluminum nitride, it is hard to produce the fault such as an exfoliation of a junction interface between this thin film conductivity material and the thin film which comprises as the main ingredients at least one or more materials selected from a gallium nitride, an indium nitride, and an aluminum nitride or a crack in the inside of a thin film which comprises as the main ingredients at least one or more materials selected from a gallium nitride, an indium nitride, and an aluminum nitride, etc.

Moreover, this invention is a substrate for thin film formation in which a thin film comprises at least one or more materials selected from a gallium nitride, an indium nitride, and an aluminum nitride as the main ingredients, and the substrate includes a substrate for thin film formation which consists of a sintered compact which comprises an aluminum nitride as the main ingredients and which formed the thin film conductivity material.

And, it is a thin film substrate in which the thin film which comprises as the main ingredients at least one or more materials selected from a gallium nitride, an indium nitride, and an aluminum nitride is formed on the sintered compact which comprises an aluminum nitride as the main ingredients, and the thin film conductivity material is being formed furthermore.

Thus, in this invention, the various substrates for thin film formation and a thin film substrate can be provided, such as, 1) the substrate for thin film formation by which the thin film conductivity material was formed on the sintered compact which comprises an aluminum nitride as the main ingredients, 2) the thin film substrate in which the thin film which comprises as the main ingredients at least one or more materials selected from a gallium nitride, an indium nitride, and an aluminum nitride was formed on the sintered compact which comprises an aluminum nitride as the main ingredients and which formed beforehand the thin film conductivity material, 3) the thin film substrate which formed the thin film conductivity material further on the thin film which comprises as the main ingredients at least one or more materials selected from a gallium nitride, an indium nitride, and an aluminum nitride and was formed on the sintered compact which comprises an aluminum nitride as the main ingredients, 4) the thin film substrate which formed furthermore the film conductivity material on the thin film which comprises as the main ingredients at least one or more materials selected from a gallium nitride, an indium nitride, and an aluminum nitride and which is being formed on the sintered compact which comprises an aluminum nitride as the main ingredients and which formed beforehand the thin film conductivity material, etc.

In each thin film substrate of the above 2), 3), and 4), the thin film substrate by which the thin film conductivity material was formed in the inside of the thin film which comprises as the main ingredients at least one or more materials selected from a gallium nitride, an indium nitride, and an aluminum nitride currently formed can also be provided.

As for the effect using the substrate for thin film formation and the thin film substrate in which the above-mentioned thin film conductivity material was formed on the sintered compact which comprises an aluminum nitride as the main ingredients according to this invention, this substrate for thin film formation and this thin film substrate can be used not only as a substrate for forming the thin film which comprises as the main ingredients at least one or more materials selected from a gallium nitride, an indium nitride, and an aluminum nitride but also, for example, as a substrate to which the electrical circuit facility for making the light emitting device formed on the substrate for thin film formation and the thin film substrate in which this thin film conductivity material was formed by processing the above-mentioned thin film conductivity material into the shape of a circuit pattern drive electrically was added.

Furthermore, if the substrate for thin film formation and the thin film substrate which formed the above-mentioned thin film conductivity material on the sintered compact which comprises an aluminum nitride as the main ingredients and which has a conduction via are used, the effect whose electric connection nature on the surface of up-and-down of a substrate improves will be acquired if it is compared with the case where the sintered compact which comprises an aluminum nitride as the main ingredients and which has the conduction via whose this thin film conductivity material is not formed is used.

That is, if the thin film which comprises as the main ingredients at least one or more materials selected from a gallium nitride, an indium nitride, and an aluminum nitride has conductivity, this thin film which has this conductivity and the substrate surface of the opposite side in which this thin film is being formed are electrically connectable via a conduction via.

Since the above-mentioned thin film conductivity material can be used as a reflective material of the light emitted from this light emitting device when forming a light emitting device on the substrate for thin film formation or the thin film substrate in which the above-mentioned thin film conductivity material by this invention was formed, it is effective in condensing efficiently the light emitted from a light emitting device, or becoming possible to emit the light into the specific direction.

That is, when he wants to emit the light emitted from the luminescence layer of a light emitting device into the device exterior not from the side of the substrate which consists of a sintered compact which comprises an aluminum nitride as the main ingredients but from the direction of the opposite side, or to condense the light into the specific direction of the opposite side, it can realize comparatively easily by forming the above-mentioned thin film conductivity material in the substrate as a reflective material.

For example, in the surface emission-type laser diode (LD) and the light emitting diode (LED) used a flat panel display etc., that to control the light from a light emitting device into the specific direction is desired.

When the substrate which consists of a sintered compact which comprises an aluminum nitride as the main ingredients and does not form the above-mentioned thin film conductivity material is used, since the reflectance of this sintered compact which comprises an aluminum nitride as the main ingredients to the light of at least 200 nm wavelength or wavelength longer than 200 nm is usually as low as not more than 15%, even if it uses the sintered compact which comprises an aluminum nitride as the main ingredients and has a small optical permeability as a substrate in order to prevent the light transmission from the substrate side, in many cases, it will become difficult to carry out efficiently the control of direction and the control of condensing of the light from the light emitting device.

Even if it is the light emitting device which is produced by using the substrate which formed the above-mentioned thin film conductivity material as a reflective material, it is rare for luminous efficiency to lower greatly if it is compared with the case where conventional substrates, such as sapphire etc., are used, the light emitting device which has luminous efficiency of at least equivalent or more can provide.

What has luminous efficiency at least not less than 8% is usually producible, if it is the light emitting device which is produced by using the substrate which formed the above-mentioned thin film conductivity material as a reflective material.

Among such thin film conductivity materials, for example, what has low resistance of the specific resistance of not more than 1×10⁻³ Ω·cm in room temperature is preferred to use as a conductor of an electrical circuit.

What has the high specific resistance of not less than 1×10⁻³ Ω·cm is preferred to use as a resistor of an electrical circuit.

When using the above-mentioned thin film conductivity material as a reflective material by forming it in a substrate for light emitting device production which consists of a sintered compact which comprises an aluminum nitride as the main ingredients, it is usually formed on the surface of a substrate.

When using this thin film conductivity material as a reflective material, as for the reflectance to the light from a light emitting device, it is preferred to use what is not less than 15%.

It is more preferred that the reflectance to the light from a light emitting device uses not less than 50% of material.

It is still more preferred that the reflectance to the light from a light emitting device uses not less than 70% of material.

It is most preferred that the reflectance to the light from a light emitting device uses not less than 80% of material.

The reflectance to the above-mentioned light from the light emitting device is a reflectance to the light of at least the range of 200 nm-800 nm wavelength.

The reflectance to the light of the range of 200 nm-800 nm wavelength means the reflectance measured by the light of the specific wavelength of the range of 200 nm-800 nm wavelength.

In this invention, unless reference is made especially, usually the reflectance to light with a wavelength 605 nm was used.

The above-mentioned thin film conductivity material can use what was formed to the sintered compact which comprises an aluminum nitride as the main ingredients as metallizing of 1 layer structure only using the single material selected from gold, silver, copper, aluminum, iron, cobalt, nickel, ruthenium, rhodium, palladium, osmium, iridium, platinum, tantalum, molybdenum, tungsten, chromium, titanium, nickel chromium alloy, titanium nitride, zirconium nitride, and tantalum nitride, etc.

In addition to this, what is a thin film multilayered structure can also be used, such as for example, chromium/copper, titanium/molybdenum/gold, titanium/tungsten/nickel, titanium/tungsten/gold, titanium/platinum/gold, titanium/nickel/gold, zirconium/tungsten/gold, and zirconium/platinum/gold, using chromium, titanium, zirconium, titanium nitride, and zirconium nitride, etc. as an adhesion material with the sintered compact which comprises an aluminum nitride as the main ingredients, and forming suitably iron, cobalt, nickel, rhodium, palladium, osmium, iridium, platinum, molybdenum, tungsten, titanium nitride, and zirconium nitride, etc. as a barrier material onto it, furthermore forming suitably a low resistive material, such as gold, silver, copper, and aluminum, etc.

What has 1 layer structure or multilayered structure in which low resistive materials, such as gold, silver, copper, and aluminum, etc. are used as the main ingredients among the above-mentioned thin film conductivity materials is preferred to use as a conductor of an electrical circuit.

As for the material with high specific resistance, such as tantalum nitride and nickel chromium alloy, using as a resistor of an electrical circuit is preferred.

As the above-mentioned tantalum nitride, Ta, the compounds of Ta and N (for example, TaN, Ta2N, etc.), and the thin film of an amorphous Ta-N composition system, etc. can be used.

When this thin film conductivity material is used as a reflective material, the metal or alloy which comprise as the main ingredients one or more materials among beryllium (Be), magnesium (Mg), scandium (Sc), yttrium (Y), a rare earth metal, titanium (Ti), zirconium (Zr), hafnium (Hf), Vanadium (V), niobium (Nb), tantalum (Ta), chromium (Cr), Molybdenum (Mo), tungsten (W), manganese (Mn), rhenium (Re), Iron (Fe), cobalt (Co), nickel (Ni), ruthenium (Ru), Rhodium (Rh), palladium (Pd), osmium (Os), iridium (Ir), Platinum (Pt), copper (Cu), silver (Ag), gold (Au), zinc (Zn), boron (B), aluminum (Al), gallium (Ga), indium (In), silicon (Si), germanium (Ge), tin (Sn), lead (Pb), antimony (Sb), bismuth (Bi), etc., for example, can be used suitably.

As an alloy, the reflectance of these metals or alloys is usually not less than 15% to the light with a wavelength 605 nm, and it can be enough used as a reflective material by being formed on the surface of a substrate.

Among the above-illustrated materials, as for the metal or alloy which comprise as the main ingredients one or more elements selected from Cu, Ag, Au, Al, Mg, Zn, Mo, W, Mn, Fe, Co, Ni, Rh, Pd, Os, Ir, and Pt, since it is easy to obtain the thing whose reflectance to the light with a wavelength 605 nm is as high as not less than 50%, and loss is small, it is preferred. Moreover, among the above-mentioned metallic material or the alloy materials, as for the metal or alloy which comprise as the main ingredients one or more elements selected from Cu, Ag, Au, Al, Mg, Zn, Fe, Co, NI, Rh, Pd, Os, Ir, and Pt, since it is easy to obtain the thing whose reflectance to the light with a wavelength 605 nm is as high as not less than 70%, and loss is smaller, it is preferred.

Among these metals or alloys, as for an alloy with Cu, Ag, Au, W, and Mo, such as copper/tungsten, copper/molybdenum, silver/tungsten, silver/molybdenum, gold/tungsten, and gold/molybdenum, etc., since it is easy to obtain the thing whose reflectance to the light with a wavelength 605 nm is as high as not less than 50%, and furthermore what has as high reflectance as not less than 70% can be obtained depending on composition, it can use suitably as a reflective material.

Among the above-illustrated 14 kinds of metal or alloy which is reflectance not less than 70%, as for the metal or alloy which comprises as the main ingredients at least one or more materials selected from platinum groups, such as Rh, Pd, Os, Ir, and Pt, since what is reflectance not less than 80% is obtained according to production conditions, it is preferred.

Moreover, among these metals or alloys which are reflectance not less than 70%, as for the metal or alloy which comprises as the main ingredients Cu, Ag, Au, and Al, since it is easy to obtain the thing whose reflectance to the light with a wavelength 605 nm is as high as not less than 80%, and loss is smallest, it is preferred.

Thus, when the thin film conductivity material which consists of the various metals or alloy illustrated above is used by forming it in the substrate for light emitting device production according to this invention, this thin film conductivity material has a facility as a good reflective material to the light from a light emitting device.

The reflectance of a thin film conductivity material can be easily performed using optical apparatus, such as a spectrophotometer (Spectrophotometer).

In this invention, the above-mentioned thin film conductivity material can also form not only on the sintered compact which comprises an aluminum nitride as the main ingredients but also on the various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and other various sintered compacts which comprise a ceramic material as the main ingredients.

What has a conduction via can be used as the various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and other various sintered compacts which comprise a ceramic material as the main ingredients.

On the substrate which formed the above-mentioned thin film conductivity material and which consists of the various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system or a hexagonal system, such as an aluminum oxide etc., and other various sintered compacts which comprise a ceramic material as the main ingredients, the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal can form furthermore.

This thin film can be formed not only as single layer but also as a two or more-layer thin film layer in which a crystallized state, composition, etc. differs.

In the substrate which currently forms a thin film conductivity material and which consists of various sintered compacts which comprise as the main ingredients a ceramic material which has the crystal structure which can be classified as a hexagonal system such as a silicon carbide, a silicon nitride, a zinc oxide, and a beryllium oxide etc., and classified as a trigonal system system or a hexagonal system, such as an aluminum oxide etc., and in the other various sintered compacts which comprise a ceramic material as the main ingredients, an epitaxially grown single crystal thin film which comprises as the main ingredients at least one or more materials selected from a gallium nitride, an indium nitride, and an aluminum nitride can be formed, in addition, the thin film which has at least one of crystallized states selected from amorphous state, polycrystal, and orientated polycrystal and which is not a single crystal can also be formed.

What is the multilayered thin film constitution of two or more layers can also be formed not only as single layer.

That is, by beforehand forming the thin film which comprises as the main ingredients at least one or more materials selected from a gallium nitride, an indium nitride, and an aluminum nitride and which consists of at least one of the crystallized states selected from a single crystal, an amorphous state, a polycrystal, and an orientated polycrystal, the thin film of 2 layers constitution with which the epitaxially grown single crystal thin film which comprises as the main ingredients at least one or more materials selected from a gallium nitride, an indium nitride, and an aluminum nitride was formed on it can be formed.

As for the crystallinity of the single crystal thin film which was formed in such constitution, since what is superior to the single crystal thin film directly formed on the substrate which consists of a sintered compact which currently forms thin film conductivity material and comprises an aluminum nitride as the main ingredients, it is preferred.

For example, the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed, the thin film of 2 layers constitution with which the thin film which consists of at least one of the crystallized states selected from an amorphous state, a polycrystal, and an orientated polycrystal which does not contain a single crystal on it was formed can also be formed.

The thin film formed by two or more layers can be formed in the condition of differing in each layer, respectively, such as crystallized states, such as including a single crystal, an amorphous state, a polycrystal, and an orientated polycrystal, composition, or thickness, and even if all the two or more-layer thin film layers are the thin film constitutions which are not single crystals in this invention, it can be formed.

All the thin film layers which are being constituted with a two or more-layer thin film layer can form what consists of a single crystal thin film which comprises as the main ingredients at least one or more materials selected from a gallium nitride, an indium nitride, and an aluminum nitride.

As for at least one or more layers among the thin film layers which are being constituted with two or more layers, and if it requires, as for a surface thin film layer, it is preferred that it is a single crystal.

Especially, when the thin film substrate in which the thin film which comprises as the main ingredients at least one or more materials selected from a gallium nitride, an indium nitride, and an aluminum nitride was formed on the substrate according to this invention in which the thin film conductivity material was formed beforehand is used for production of various electronic devices and electronic parts, such as a light emitting device, a field emission display, a wiring board, or an optical waveguide, etc., as for the thin film formed at the surface portion of the substrate, it is preferred that it is usually the single crystal which grew epitaxially.

Although a thin film conductivity material can be formed on the substrate which consists of a sintered compact which comprises an aluminum nitride as the main ingredients in which the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal was formed, in this invention, a thin film conductivity material can be formed not only on the substrate which consists of the above-mentioned sintered compact which comprises an aluminum nitride as the main ingredients but also on the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such an aluminum oxide, etc. and other various sintered compacts which comprise a ceramic material as the main ingredients, in which the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed.

As mentioned above, in this invention, various electronic devices and electronic parts, such as a light emitting device, a field emission display, a wiring board, or an optical waveguide, are producible using the substrate which consists of various sintered compacts which formed the thin film conductivity material and which comprise as the main ingredients a ceramic material having the crystal structure which can be classified as a hexagonal system, such as a silicon carbide, a silicon nitride, a zinc oxide, and beryllium oxide etc., and classified as a trigonal system or a hexagonal system, such as an aluminum oxide etc., and other various sintered compacts which comprise a ceramic material as the main ingredients.

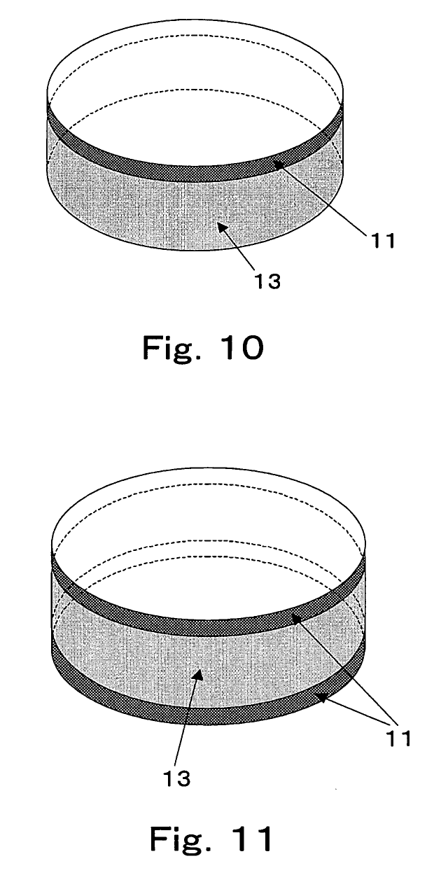

Hereafter, in FIG. 10-20 and FIG. 37-38, examples of the substrate for thin film formation and thin film substrate which form the thin film conductivity material according to this invention are shown.

The perspective diagram indicated FIG. 10-20 and FIG. 37-38.

FIG. 10 is a figure showing one example of the substrate for thin film formation by which the thin film conductivity material 11 was formed on the substrate 13 which consists of a sintered compact which comprises an aluminum nitride as the main ingredients.

FIG. 11 is a figure showing one example of the substrate for thin film formation by which the thin film conductivity material 11 was formed in both sides of the substrate 13 which consists of a sintered compact which comprises an aluminum nitride as the main ingredients.

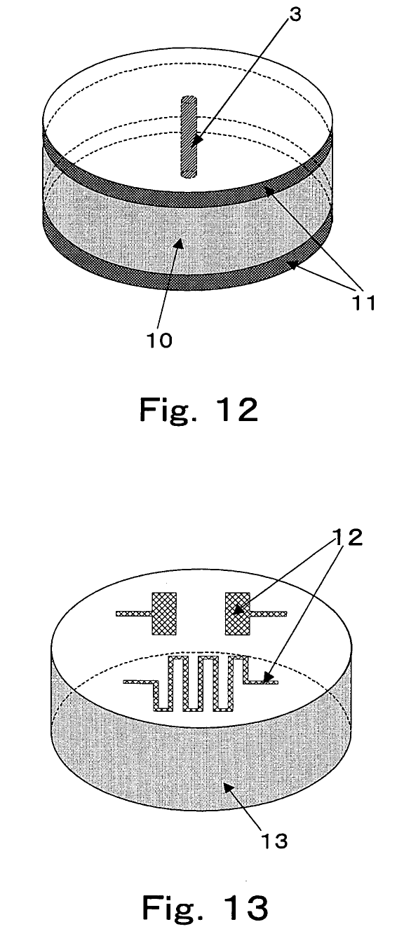

FIG. 12 is a figure showing one example of the substrate for thin film formation by which the thin film conductivity material 11 was formed in both sides of the substrate 10 which consists of a sintered compact which comprises an aluminum nitride as the main ingredients and which has a conduction via.

Thin film conductivity material 11 formed in both sides of the substrate was connected mutually electrically by the conduction via.

FIG. 13 is a figure showing one example of the substrate for thin film formation by which the thin film conductivity material of a circuit pattern 12 was formed on the substrate 13 which consists of a sintered compact which comprises an aluminum nitride as the main ingredients.

In this invention, the thin film which comprises as the main ingredients at least one or more materials selected from a gallium nitride, an indium nitride, and an aluminum nitride can be formed on the circuit patterns.

Or by avoiding these circuit patterns, the thin film which comprises as the main ingredients at least one or more materials selected from a gallium nitride, an indium nitride, and an aluminum nitride can also be formed on the portion of the sintered compact which comprises an aluminum nitride as the main ingredients in which the circuit pattern is not formed.

In the substrate for thin film formation which formed the thin film conductivity material according to this invention as an electrical circuit pattern, if functional devices, such as a light emitting device, are formed on this substrate for thin film formation, for example, it functions also as a wiring board for mounting a light emitting device or a substrate unified as a package.

Therefore, usually, although the wiring board or package for mounting a functional device, such as a light emitting device, is required, the effect of it becoming unnecessary to prepare a wiring board or a package independently is acquired, if using the substrate with which the function was united according to this invention.

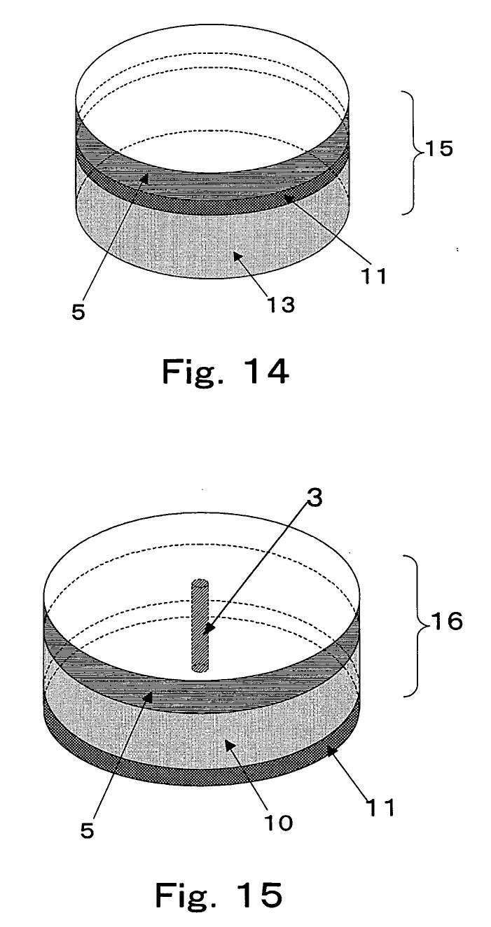

FIG. 14 is a figure showing one example of a thin film substrate in which the thin film 5 which comprises as the main ingredients at least one or more materials selected from a gallium nitride, an indium nitride, and an aluminum nitride is being formed on the substrate which consists of a sintered compact which comprises an aluminum nitride as the main ingredients and which formed beforehand the thin film conductivity material.

In FIG. 14, the thin film substrate 15 is being constituted by forming the thin film 5 which comprises as the main ingredients at least one or more materials selected from a gallium nitride, an indium nitride, and an aluminum nitride on the substrate 13 which consists of a sintered compact which comprises an aluminum nitride as the main ingredients and which formed the thin film conductivity material 11.

FIG. 15 is a figure showing one example of a thin film substrate in which the thin film which comprises as the main ingredients at least one or more materials selected from a gallium nitride, an indium nitride, and an aluminum nitride is being formed on the substrate which consists of a sintered compact which comprises an aluminum nitride as the main ingredients and has a conduction via and which formed beforehand the thin film conductivity material.

In FIG. 15, the thin film substrate 16 is being constituted by forming the thin film 5 which comprises as the main ingredients at least one or more materials selected from a gallium nitride, an indium nitride, and an aluminum nitride on the surface where this thin film conductivity material 11 is not being formed on the substrate 10 which consists of a sintered compact which comprises an aluminum nitride as the main ingredients and has a conduction via 3 and which formed beforehand the thin film conductivity material 11 on one side of a substrate.

In FIG. 15, if the thin film 5 which comprises as the main ingredients at least one or more materials selected from a gallium nitride, an indium nitride, and an aluminum nitride has conductivity, this thin film 5 which has conductivity and the substrate surface of the opposite side in which this thin film 5 is being formed are electrically connectable via conduction via 3.

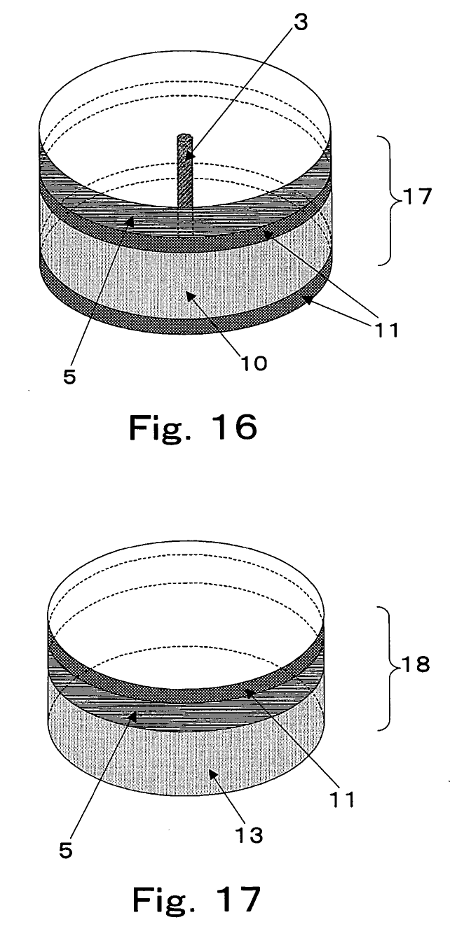

FIG. 16 is a figure showing one example of a thin film substrate in which the thin film 5 which comprises as the main ingredients at least one or more materials selected from a gallium nitride, an indium nitride, and an aluminum nitride is being formed on the substrate which consists of a sintered compact which formed beforehand a thin film conductivity material on both sides and which has the conduction via and comprises an aluminum nitride as the main ingredients.

In FIG. 16, the thin film substrate 17 is being constituted by forming the thin film 5 which comprises as the main ingredients at least one or more materials selected from a gallium nitride, an indium nitride, and an aluminum nitride on the substrate 10 which consists of a sintered compact which formed beforehand the thin film conductivity material 11 on both sides and which has the conduction via 3 and comprises an aluminum nitride as the main ingredients.

In FIG. 16, if the thin film 5 which comprises as the main ingredients at least one or more materials selected from a gallium nitride, an indium nitride, and an aluminum nitride has conductivity, it is electrically connectable with the substrate surface of the opposite side in which this thin film 5 is being formed via the thin film 5 and conduction via 3 which have this conductivity with higher reliability.

FIG. 17 shows one example of the thin film substrate which formed the thin film conductivity material further on the thin film which comprises as the main ingredients at least one or more materials selected from a gallium nitride, an indium nitride, and an aluminum nitride and was formed on the substrate which consists of a sintered compact which comprises an aluminum nitride as the main ingredients.

In FIG. 17, the appearance of the thin film substrate 18 in which the thin film conductivity material 11 was formed on the thin film 5 which comprises as the main ingredients at least one or more materials selected from a gallium nitride, an indium nitride, an aluminum nitride was formed on the substrate 13 which consists of a sintered compact which comprises an aluminum nitride as the main ingredients is shown.

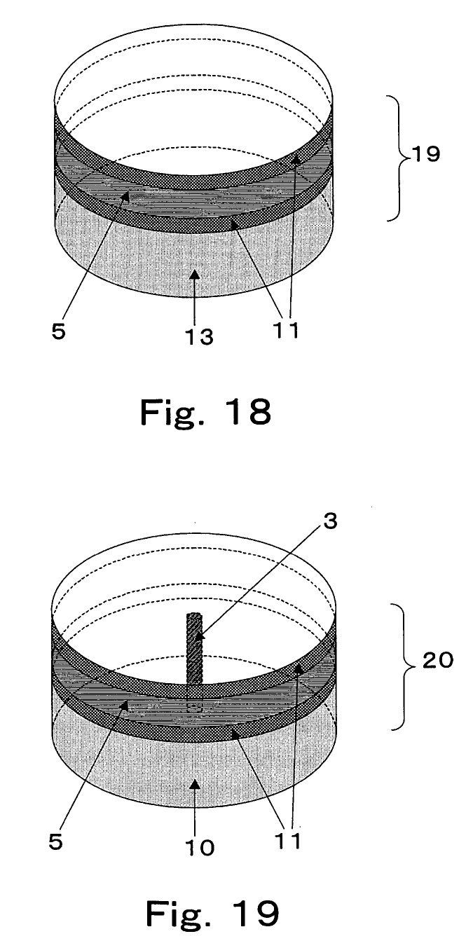

FIG. 18 shows one example of the thin film substrate in which the thin film conductivity material was formed furthermore on the thin film which comprises as the main ingredients at least one or more materials selected from a gallium nitride, an indium nitride, and an aluminum nitride was formed on the substrate which consists of a sintered compact which comprises an aluminum nitride as the main ingredients and which formed beforehand the thin film conductivity material.

In FIG. 18, the appearance of the thin film substrate 19 in which the thin film 5 which comprises as the main ingredients at least one or more materials selected from a gallium nitride, an indium nitride, and an aluminum nitride was formed on the substrate 13 which consists of a sintered compact which comprises an aluminum nitride as the main ingredients and which formed beforehand the thin film conductivity material 11, and the thin film conductivity material 11 was formed furthermore on the surface of a thin film 5 is shown.

FIG. 19 shows one example of the thin film substrate in which the thin film conductivity material was formed furthermore on the thin film which comprises as the main ingredients at least one or more materials selected from a gallium nitride, an indium nitride, and an aluminum nitride was formed on the substrate which consists of a sintered compact which comprises an aluminum nitride as the main ingredients and has a conduction via and which formed beforehand the thin film conductivity material.

In FIG. 19, the thin film 5 which comprises as the main ingredients at least one or more materials selected from a gallium nitride, an indium nitride, and an aluminum nitride was formed on the substrate 10 which consists of a sintered compact which formed beforehand the thin film conductivity material 11 and which has a conduction via 3 and comprises an aluminum nitride as the main ingredients, and the appearance of the thin film substrate 20 in which the thin film conductivity material 11 was formed furthermore on the surface of a thin film 5 is shown.

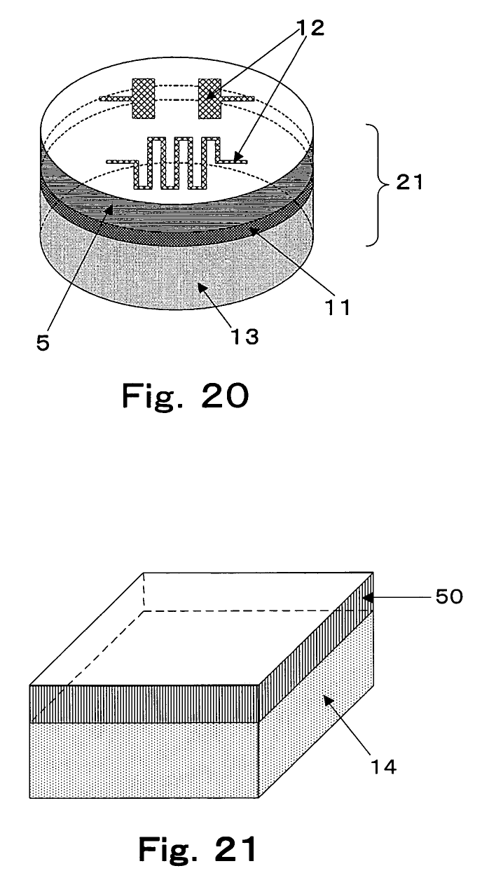

FIG. 20 shows one example of the thin film substrate in which the electrical circuit pattern by a thin film conductivity material was formed furthermore on surface of this thin film which comprises as the main ingredients at least one or more materials selected from a gallium nitride, an indium nitride, and an aluminum nitride was formed on the substrate which consists of a sintered compact on which the thin film conductivity material was formed beforehand and which comprises an aluminum nitride as the main ingredients.

In FIG. 20, the appearance of the thin film substrate 21 in which the thin film 5 which comprises as the main ingredients at least one or more materials selected from a gallium nitride, an indium nitride, and an aluminum nitride was formed on the substrate 13 which consists of a sintered compact which comprises an aluminum nitride as the main ingredients and which formed beforehand the thin film conductivity material 11, and the thin film conductivity material 12 of circuit pattern form was formed furthermore on the surface of a thin film 5 is shown.

FIG. 37 shows one example of the thin film substrate in which two layers of thin films which comprise as the main ingredients at least one or more materials selected from a gallium nitride, an indium nitride, and an aluminum nitride were formed on the substrate which consists of a sintered compact which comprises an aluminum nitride as the main ingredients and which formed beforehand the thin film conductivity material.

In FIG. 37, the thin film substrate of a constitution in which the thin film 8 which comprises as the main ingredients at least one or more materials selected from a gallium nitride, an indium nitride, and an aluminum nitride was formed furthermore on the thin film 5 which comprises as the main ingredients at least one or more materials selected from a gallium nitride, an indium nitride, and an aluminum nitride was formed on the substrate 13 which consists of a sintered compact which comprises an aluminum nitride as the main ingredients and which formed beforehand the thin film conductivity material 11 is shown with the mark 22.

For example, if what comprises as the main ingredients at least one or more materials selected from a gallium nitride, an indium nitride, and an aluminum nitride and has at least one of the crystallized states selected from a single crystal, an amorphous state, a polycrystal, and an orientated polycrystal is formed as a thin film 5, and the epitaxially grown single crystal thin film which comprises as the main ingredients at least one or more materials selected from a gallium nitride, an indium nitride, and an aluminum nitride is formed on it as a thin film 8, since the crystallinity of this thin film 8 tends to improve rather than the crystallinity of the single crystal thin film directly formed on the substrate 13, it is preferred.

The thin film substrate of such thin film constitution is preferred when using it for production of various electronic devices and electronic parts, such as a light emitting device, field emission, a wiring board, or an optical waveguide.

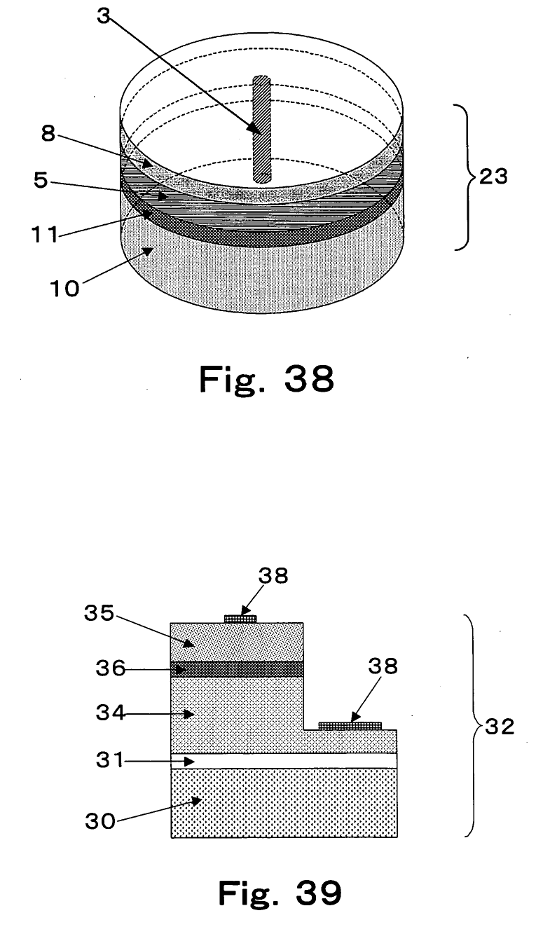

FIG. 38 shows one example of the thin film substrate in which two layers of thin films which comprise as the main ingredients at least one or more materials selected from a gallium nitride, an indium nitride, and an aluminum nitride were formed on the substrate which consists of a sintered compact on which the thin film conductivity material was formed beforehand and which has a conduction via and comprises an aluminum nitride as the main ingredients.

In FIG. 38, the thin film substrate of a constitution in which the thin film 8 which comprises as the main ingredients at least one or more materials selected from a gallium nitride, an indium nitride, and an aluminum nitride was formed furthermore on the thin film 5 which comprises as the main ingredients at least one or more materials selected from a gallium nitride, an indium nitride, and an aluminum nitride was formed on the substrate 10 which consists of a sintered compact which comprises an aluminum nitride as the main ingredients and which formed beforehand the thin film conductivity material 11 is shown with the mark 23.

For example, if what comprises as the main ingredients at least one or more materials selected from a gallium nitride, an indium nitride, and an aluminum nitride and has at least one of the crystallized states selected from a single crystal, an amorphous state, a polycrystal, and an orientated polycrystal is formed as a thin film 5, and the epitaxially grown single crystal thin film which comprises as the main ingredients at least one or more materials selected from a gallium nitride, an indium nitride, and an aluminum nitride is formed on it as a thin film 8, since the crystallinity of this thin film 8 tends to improve rather than the crystallinity of the single crystal thin film directly formed on the substrate 10, it is preferred.

The thin film substrate of such thin film constitution is preferred when using it for production of various electronic devices and electronic parts, such as a light emitting device, field emission, a wiring board, or an optical waveguide.

When the substrate in which the thin film conductivity material was formed is used as a substrate for light emitting device production for example, the thin film conductivity material which provided space can be used in order to prevent that it becomes that the light emitted from the light emitting device is intercepted by thin film conductivity material, and is hard to be emitted to the substrate exterior.

If a space is established in a thin film conductivity material, since the light emitted from the light emitting device will pass through this space without being intercepted by the thin film conductivity material it becomes that it is easy to be emitted to the substrate exterior and the luminous efficiency of a light emitting device is raised, it is preferred.

Although the example using the sintered compact which comprises an aluminum nitride as the main ingredients is shown in the substrate in which the thin film conductivity material was formed shown in FIG. 10-20 and FIG. 37-38, in this invention, it can replace the substrate which consists of the above-mentioned sintered compact which comprises an aluminum nitride as the main ingredients (namely, respectively, the substrate shown with the mark 13 of FIG. 10, the substrate shown with the mark 13 of FIG. 11, the substrate shown with the mark 10 of FIG. 12, the substrate shown with the mark 13 of FIG. 13, the substrate shown with the mark 13 of FIG. 14, the substrate shown with the mark 10 of FIG. 15, the substrate shown with the mark 10 of FIG. 16, the substrate shown with the mark 13 of FIG. 17, the substrate shown with the mark 13 of FIG. 18, the substrate shown with the mark 10 of FIG. 19, the substrate shown with the mark 13 of FIG. 20), and the substrate for thin-film formation and thin-film substrate which are same mode as the thing illustrated in FIG. 10-20 and which formed the above-mentioned thin-film conductivity material are producible using the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., and other various sintered compacts which comprise a ceramic material as the main ingredients.

According to this invention, in the substrate which consists of a sintered compact which comprises an aluminum nitride as the main ingredients, or in the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., a single crystal thin film which comprises as the main ingredients at least one or more materials selected from a gallium nitride, an indium nitride, and an aluminum nitride can be formed directly as mentioned above.

This inventor has conducted the experiment for forming the single crystal thin film which comprises as the main ingredients at least one or more materials selected from a gallium nitride, an indium nitride, and an aluminum nitride on the substrate which consists of a sintered compact which comprises an aluminum nitride as the main ingredients, or on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide, etc, in the process, it newly found out that the thin film which comprises as the main ingredients at least one or more materials selected from a gallium nitride, an indium nitride, and an aluminum nitride which is not necessarily a single crystal could be formed.

That is, this thin film is that is various crystallized states, such as not only a single crystal state but an amorphous state, and a polycrystalline state or an orientated polycrystalline state, the thin film of these various crystallized states also can be directly formed on the substrate which consists of a sintered compact which comprises an aluminum nitride as the main ingredients and on the substrate which consists of various ceramic materials which have the crystal system which can be classified as a hexagonal system, such as a silicon carbide, a silicon nitride, a zinc oxide, and a beryllium oxide etc., and classified as a trigonal system or a hexagonal system, such as an aluminum oxide etc.

An orientated polycrystal means the polycrystal with which the crystal grew up to be specific one direction.

For example, in the polycrystal with which C axis grew in the perpendicular direction to the substrate surface, the crystallographic axis which exists in the level direction to a surface of the substrate has turned to all directions, unlike the single crystal.

If it was the single crystal thin film which comprises as the main ingredients at least one or more materials selected from a gallium nitride, an indium nitride, and an aluminum nitride the C axis grows in the perpendicular direction to a substrate surface, an A-axis grows in the level direction to a substrate surface, and the direction is fixed, but in an orientated polycrystal, even if C axis is growing in the perpendicular direction to a substrate surface, an A-axis of level direction to a substrate does not have fixed directivity.

As for the substrate which consists of a sintered compact which comprises an aluminum nitride as the main ingredients, and the substrate which consists of various sintered compacts which comprise a ceramic material as the main ingredients, the substrate which has a conduction via is also included.

This invention was made by being based on the knowledge in which a thin film which is not necessarily only a single crystal, such as an amorphous state which comprises as the main ingredients at least one or more materials selected from a gallium nitride, an indium nitride, and an aluminum nitride, can also be formed directly, onto the substrates which are able to form the single crystal thin film which comprises as the main ingredients at least one or more materials selected from a gallium nitride, an indium nitride, and an aluminum nitride, such as the substrate which consists of a sintered compact which comprises an aluminum nitride as the main ingredients, and the substrate which consists of various sintered compacts which comprise as the main ingredients a ceramic material which has the crystal system which can be classified as a hexagonal, such as a silicon carbide, a silicon nitride, a zinc oxide, and a beryllium oxide etc., and classified as a trigonal system or a hexagonal system, such as an aluminum oxide etc.,

tioned amorphous thin film, the polycrystalline thin film, or the orientated polycrystalline thin film which comprise as the main ingredients at least one or more materials selected from a gallium nitride, an indium nitride, and an aluminum nitride can be formed comparatively easily like a single crystal thin film.

That is, the above-mentioned thin films other than a single crystal can be formed by methods, such as an MOCVD (Metal Organic Chemical Vapor Deposition) method, an MOVPE (Metal Organic Vapor Phase Epitaxy) method, a Hydride VPE (Hydride Vapor Phase Epitaxy) method, a Chloride VPE (Chloride Vapor Phase Epitaxy) method, a Plasma CVD method, other CVD (Chemical Vapor Deposition) method, and an MBE (Molecular Beam Epitaxy) method.

or such as the method of usually using for epitaxial growth, such as a laser ablation method using excimer laser etc, and a PLD (pulsed-laser deposition: pulsed laser decomposition) method, by using the solid material containing the purpose ingredient formed beforehand as a raw material, or such as a Sputtering method, an Ion-plating method, and a Vacuum deposition, etc.

When thin films of a single crystal or other than a single crystal are formed by using the above-mentioned methods of thin film forming, it can carry out easily by modification of thin film formation conditions, for example, the temperature of a substrate is set up low or making concentration of thin film source gas into height, etc.

For example, when by using the various kinds of CVD, such as the above MOCVD, a Hydrides VPE method, a Chloride VPE method, and a Halide VPE method, or a Sputtering method, and an Ion-plating method, the thin film which comprises as the main ingredients at least one or more materials selected from a gallium nitride, an indium nitride, and an aluminum nitride is directly formed on the substrate which consists of a sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., by setting the temperature of this substrate comparatively high to not less than 600 degrees C.-700 degrees C. in the case of a single crystal thin film, and by setting the temperature of this substrate to not more than 600 degrees C.-700 degrees C., for example, not more than 500 degrees C. moreover not more than 400 more degrees C. in the case of forming thin films other than a single crystal, it is possible to make respectively a single crystal thin film and thin films other than a single crystal comparatively easily.

For example, when forming the thin film of a gallium nitride by an MOCVD method by using Trimethyl gallium as a raw material, the single crystal thin films can be formed at 700 degrees C.-800 degrees C. or more, preferably at 900 degrees C.-1100 degrees C.

The thin film of an amorphous state, a polycrystalline state, or an orientated polycrystalline state can be formed at not more than 800 degrees C., for example, the temperature not more than 600 degrees C.

Not only by using a single method, when performing the formation of the above-mentioned thin film which comprises as the main ingredients at least one or more materials selected from a gallium nitride, an indium nitride, and an aluminum nitride, but by combining two or more methods, for example, it carries out combining an MOCVD method and a Sputtering method, or combining a Chloride VPE method and a Sputtering method, or combining the three methods of an MOCVD method, a Chloride VPE method, and a Sputtering method, the above-mentioned thin film can be formed.

By such combination, first, the thin film of an orientated polycrystalline state with which the crystal C axis grew perpendicularly to the substrate surface or the thin film of an amorphous state which comprises as the main ingredients at least one or more materials selected from a gallium nitride, an indium nitride, and an aluminum nitride is formed beforehand by the Sputtering method, for example, on the substrate which consists of a sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., it can carry out arbitrarily forming the thin film of the single crystal state which comprises as the main ingredients at least one or more materials selected from a gallium nitride, an indium nitride, and an aluminum nitride onto it by the MOCVD method or the Chloride VPE method etc., etc.

Furthermore, even if by using the thin film forming methods which cannot usually form a single crystal thin film easily, such as an Ion-plating method or Vacuum deposition, the films other than a single crystal have the characteristics that direct formation can be carried out comparatively easily on the substrate which consists of a sintered compact which comprises an aluminum nitride as the main ingredients.

When forming such thin films other than a single crystal by using an Ion-plating method or Vacuum deposition, as for the temperature of the substrate which consists of a sintered compact which comprises an aluminum nitride as the main ingredients or the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., it is performed at not more than 600 degrees C., usually at not more than 400 degrees C.

It was stated above, “it can be easily distinguished by X ray diffraction what kind of crystallized state the above-mentioned thin film is”.

That is, if it is amorphous, it will become a broad diffraction pattern and a diffraction line will not appear in the location of the specific degree of diffraction angle.

If it is polycrystal, since a diffraction pattern is easy to become a broad figure, not only one specific diffraction line (for example, diffraction line of only the diffraction line of a Miller Index (002) or (100)) but two or more diffraction lines appear, it can perform distinction of whether to be a single crystal easily.

In the case of an orientated polycrystal, according to the direction of crystal orientation, a specific diffraction line appears by the X-ray diffraction.

The diffraction line which appears in the polycrystalline thin film in which C axis orientated in the perpendicular direction to the substrate surface as mentioned above is only a diffraction line of a Miller Index (002) plane with 2θ/θscan.

The diffraction line which will appear if X-ray diffraction of 2θ/θscan is performed also in the single crystal thin film formed in the direction where C axis is perpendicular to the substrate surface is only a diffraction line of a Miller Index (002) plane.

In the case of a single crystal thin film in this invention, the diffraction line of the lattice plane of the Miller Index (002) is sharp, the thing, such that the half width of the rocking curve of the X-ray diffraction line from the lattice plane of this Miller Index (002) is not more than 3600 seconds is obtained easily.

On the other hand, in an orientated polycrystalline thin film, the diffraction line of the lattice plane of a Miller Index (002) will tend to become broad if it is compared with a single crystal, and the half width of the rocking curve of the X-ray diffraction line from the lattice plane of this Miller Index (002) tends to become not less than 3600 soconds.

Although the reason that the rocking curve of the X-ray diffraction line from the lattice plane of the Miller Index (002) of an orientated polycrystalline thin film becomes broad as mentioned above is not necessarily clear, it is surmised that while a single crystal thin film is homogeneous, continuous, and unified structure, it will be because an orientated polycrystalline thin film consists of a particulate which comprises as the main ingredients at least one or more materials selected from a gallium nitride, an indium nitride, and an aluminum nitride and arranged in the direction where only the direction of C axis is perpendicular.

Therefore, distinction with an orientated polycrystalline thin film and a single crystal thin film can be easily performed not only the method of checking the existence of the rotation in a C plane of a crystal by combining two of 2θ/θscan and 2θ/φscan of X-ray diffraction, but by performing only the above-mentioned 2θ/θscan of X-ray diffraction, and measuring the half width of a rocking curve.

Distinction with a polycrystalline thin film and a single crystal thin film can also be attained comparatively easily by performing together microstructure observation of the thin film by SEM (scanning electron microscope), SPM (scanning probe microscope), etc., or by using together RHEED (reflective high energy electron diffraction).

When the orientated polycrystalline thin film of which C axis is orientated to the perpendicular direction which comprises as the main ingredients at least one or more materials selected from a gallium nitride, an indium nitride, and an aluminum nitride is directly formed on the substrate which consists of a sintered compact which comprises an aluminum nitride as the main ingredients or on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., according to each method described above, usually, what has the crystallinity not more than 36000 seconds as half width of the rocking curve of the X-ray diffraction line from the lattice plane of the Miller Index (002) of the orientated polycrystal formed can be formed.

As for the orientated polycrystalline thin film which is formed by using an MOCVD method, an MOPVE method, a Hydrides VPE method, a Chloride VPE method, a Plasma CVD method, other CVD methods, an MBE method, a laser ablation method using excimer laser, etc., a PLD method, a Sputtering method, an Ion-plating method, and a Vacuum deposition among the various above-mentioned methods, what has the crystallinity not more than 21000 seconds as half width of the rocking curve of the X-ray diffraction line from the lattice plane of the Miller Index (002) of this thin film can be formed.

When an orientated polycrystalline thin film among the above-mentioned thin films which comprise as the main ingredients at least one or more materials selected from a gallium nitride, an indium nitride, and an aluminum nitride is directly formed on the substrate which consists of a sintered compact which comprises an aluminum nitride as the main ingredients or on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., usually, as the crystallinity of an orientated polycrystalline thin film, what excelled what uses a Sputtering method, an Ion-plating method, or a Vacuum deposition by what uses an MOCVD method, an MOPVE method, a Hydrides VPE method, a Chloride VPE method, a Plasma CVD method, other CVD methods, and an MBE method is easy to be obtained.

For example, as for what was formed using methods, such as an MOCVD method, an MOPVE method, a Hydrides VPE method, a Chloride VPE method, a Plasma CVD method, other CVD methods, and an MBE method, when the orientated polycrystalline thin film which comprises as the main ingredients at least one or more materials selected from a gallium nitride, an indium nitride, and an aluminum nitride was formed directly on the substrate which consists of a sintered compact which comprises an aluminum nitride as the main ingredients, what is not more than 5000 seconds as half width of the rocking curve of the X-ray diffraction line from the lattice plane of a Miller Index (002) can form.

When forming an orientated polycrystalline thin film using methods, such as an MOCVD method, an MOPVE method, a Hydrides VPE method, a Chloride VPE method, a Plasma CVD method, other CVD methods, and an MBE method, among the above-mentioned thin films which comprise as the main ingredients at least one or more materials selected from a gallium nitride, an indium nitride, and an aluminum nitride, if the substrate which consists of a sintered compact which comprises an aluminum nitride as the main ingredients is used, the orientated polycrystalline thin film which is more excellent in crystallinity can form. When using the above-mentioned methods, such as an MOCVD method, an MOPVE method, a Hydrides VPE method, a Chloride VPE method, a Plasma CVD method, other CVD methods, and an MBE method, the orientated polycrystalline thin film is formed directly on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., it will be easy to become larger than 5000 seconds as half width of the rocking curve of the X-ray diffraction line from the lattice plane of the Miller Index (002) of the orientated polycrystalline thin film obtained.

The semantics of directly forming such thin film which comprises as the main ingredients at least one or more materials selected from a gallium nitride, an indium nitride, and an aluminum nitride and which has various crystallized states, such as a single crystal, an amorphous state, a polycrystal, and an orientated polycrystal, on the sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is large.

That is, even if the thin film which consists of at least one or more materials selected from a gallium nitride, an indium nitride, and an aluminum nitride and which has the above-mentioned various crystallized states, such as a single crystal, an amorphous state, a polycrystal, and an orientated polycrystal is formed beforehand on the sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., the single crystal thin film which comprises as the main ingredients at least one or more materials selected from a gallium nitride, an indium nitride, and an aluminum nitride can form on the thin film of these various crystallized statescomparatively easily, thus, the advantage that the crystallinity of this formed single crystal thin film becomes easy to improve, and it can furthermore become easy to perform control of the crystal orientation of this single crystal thin film will arise.

In this invention, in the substrate which consists of a sintered compact which comprises an aluminum nitride as the main ingredients, and in the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., a single crystal thin film which has high crystallinity and comprises as the main ingredients at least one or more materials selected from a gallium nitride, an indium nitride, and an aluminum nitride can originally be formed directly.

That is, in this invention, the single crystal thin film which consists of at least one or more materials selected from a gallium nitride, an indium nitride, and an aluminum nitride can be formed directly on the substrate which consists of a sintered compact which comprises an aluminum nitride as the main ingredients, and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., and what has high crystallinity in this single crystal thin film can form.

However, as mentioned above, if the substrate which consists of a sintered compact which comprises an aluminum nitride as the main ingredients and substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., in which the thin film which consists of at least one or more materials selected from a gallium nitride, an indium nitride, and an aluminum nitride and has various crystallized states, such as a single crystal, an amorphous state, a polycrystal, and an orientated polycrystal, was formed beforehand are used, the crystallinity of the single crystal thin film which consists of at least one or more materials selected from a gallium nitride, an indium nitride, and an aluminum nitride and formed on the above-mentioned thin film of the various crystallized states becomes easy to improve further rather than the crystallinity of the single crystal thin film which comprises as the main ingredients at least one or more materials selected from a gallium nitride, an indium nitride, and an aluminum nitride and which was directly formed on the substrate which consists of a sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc.

In this invention, if the thin film which consists of as the main ingredients at least one or more materials selected from a gallium nitride, an indium nitride, and an aluminum nitride and which has at least one of the crystallized states selected from a single crystal, an amorphous state, a polycrystal, and an orientated polycrystal was formed beforehand on the substrate which consists of a sintered compact which use an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., and the single crystal thin film which comprises as the main ingredients at least one or more materials selected from a gallium nitride, an indium nitride, and an aluminum nitride is formed furthermore on this thin film, it will become possible to raise the crystallinity of this single crystal thin film further.

As for such thin film constitution, in the thin film which consists of at least 3 layers, when the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed beforehand on the substrate which consists of a sintered compact which use an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., and the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed on this thin film, and the single crystal thin film which comprises as the main ingredients at least one or more materials selected from a gallium nitride, an indium nitride, and an aluminum nitride is furthermore formed on it, the crystallinity of each single crystal thin film formed at the 2nd layer or the 3rd layer or more can be raised.

In this invention, if the substrate which consists of a sintered compact which use an aluminum nitride as the main ingredients and substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., in which the thin film of various crystallized states, such as a single crystal, an amorphous state, a polycrystal, and an orientated polycrystal, is formed is used, it will become easy to control the crystal orientation of the thin film which comprises as the main ingredients at least one or more materials selected from a gallium nitride, an indium nitride, and an aluminum nitride.

In this invention, as above-mentioned, if the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed on the substrate which consists of a sintered compact which use an aluminum nitride as the main ingredients and on the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., and the single crystal thin film which comprises as the main ingredients at least one or more materials selected from a gallium nitride, an indium nitride, and an aluminum nitride is furthermore formed on this thin film, a thin film substrate in which the single crystal thin film which has more excellent crystallinity than that formed directly on the substrate which consists of the above-mentioned various ceramic materials was formed is producible.

The characteristics of electronic devices or electronic parts produced using the thin film substrate which consists of such thin film constitution, such as a light emitting device, an optical waveguide, a wiring board, and an acoustooptics device, tend to improve.

For example, when newly forming an electronic device or electronic parts, such as this light emitting device, an optical waveguide, a wiring board, and an acoustooptics device, on the above-mentioned thin film substrate, or when using a part of various thin films which constitute the above-mentioned thin film substrate as at least a portion of the ingredient which constitutes an electronic device or electronic parts, such as a light emitting device, an optical waveguide, a wiring board, and an acoustooptics device, since it becomes easy to improve the characteristics of electronic devices or electronic-parts, such as a light emitting device, an optical waveguide, a wiring board, and an acoustooptics device, it is desirable.

In this invention, as for the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal and is formed beforehand on the substrate which consists of a sintered compact which comprises an aluminum nitride as the main ingredients, and on the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., what is the multilayered constitution of two or more layers from which composition and/or a crystallized state differ can also be used, such as not only what formed this thin film as single layer but also what was formed as a two or more-layer multilayered film layer which consists of two or more crystallized states which is different respectively, or what was formed as a two or more-layer multilayered film layer which consists of two or more composition which is different respectively even if it is the same crystallized state, etc.

Moreover, as for the single crystal thin film which comprises as the main ingredients at least one or more materials selected from a gallium nitride, an indium nitride, and an aluminum nitride which is formed on the thin film of the various above-mentioned crystallized states, what is constituted in the multilayer by which two or more thin film layers are laminated can be used, such as what has crystallinity which is different even if it is the same composition, or what has different composition, etc.

And, in what is constituted into the multilayer by laminating two or more thin film layers, at least one or more thin film layers are a single crystal state, and what consists of a constitution in which the remaining thin film layers are not a single crystal state, such as an amorphous state, a polycrystal, and an orientated polycrystal, can also be used.

What is the same composition and the same crystallized state can also be formed in 2 steps or more as two or more thin film layers.

As for the thickness of the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal and is formed beforehand on the substrate which consists of a sintered compact which use an aluminum nitride as the main ingredients, and on the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., what is arbitrary can be formed.

As for the thickness of the single crystal thin film which comprises as the main ingredients at least one or more materials selected from a gallium nitride, an indium nitride, and an aluminum nitride and forms on it furthermore, what is arbitrary can also be formed.

As for the above-mentioned thin film which is formed beforehand and which has at least one of the crystallized states selected from a single crystal an amorphous state, a polycrystal, and an orientated polycrystal and the single crystal thin film which is formed furthermore on it, what is the multilayered structure which comprises single layer of respectively arbitrary thickness or two or more thin film layers is producible.

As for the thickness of each thin film layer of the above-mentioned thin film which is formed beforehand and the single crystal thin film which is formed furthermore on it, usually, it is preferred to use, respectively, combining suitably what is a 0.5 nm-1000 μm range.

Stating more concretely, when the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed beforehand on the sintered compact which comprises an aluminum nitride as the main ingredients, then the single crystal thin film which comprises as the main ingredients at least one or more materials selected from a gallium nitride, an indium nitride, and an aluminum nitride is formed furthermore on it, not only that whose half width of the rocking curve of the X-ray diffraction line from the lattice plane of a Miller Index (002) is at least not more than 300 seconds can be formed but also what is high crystallinity not more than 100 seconds can be formed furthermore, as this single crystal thin film.

In such thin film constitution, when the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed beforehand on the sintered compact which comprises an aluminum nitride as the main ingredients, then the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed furthermore on it, thus the substrate in which the thin film of a total of two layers was formed is prepared, then the single crystal thin film which comprises as the main ingredients at least one or more materials selected from a gallium nitride, an indium nitride, and an aluminum nitride is formed furthermore on it, not only that whose half width of the rocking curve of the X-ray diffraction line from the lattice plane of a Miller Index (002) is at least not more than 300 seconds can be formed but also what is high crystallinity not more than 100 seconds can be formed furthermore, as this single crystal thin film which is formed in 2nd layer or in 3rd layer.

Such an effect is also acquired similarly, when using not only the substrate which consists of a sintered compact which comprises an aluminum nitride as the main ingredients in which one layer or two layers of thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed beforehand, but also using what formed beforehand three or more layers of thin films as a substrate.

Namely, when the single crystal thin film which comprises as the main ingredients at least one or more materials selected from a gallium nitride, an indium nitride, and an aluminum nitride is formed furthermore on the sintered compact which comprises an aluminum nitride as the main ingredients in which a total of three or more layers of thin films which comprise as the main ingredients at least one or more materials selected from a gallium nitride, an indium nitride, and an aluminum nitride and which have at least one of the crystallized states selected from a single crystal, an amorphous state, a polycrystal, and an orientated polycrystal was formed beforehand, not only that whose half width of the rocking curve of the X-ray diffraction line from the lattice plane of a Miller Index (002) is at least not more than 300 seconds can be formed but also what is high crystallinity not more than 100 seconds can be formed furthermore, as this single crystal thin film.

As mentioned above, for example, if it is going to form a single crystal thin film which comprises as the main ingredients at least one or more materials selected from a gallium nitride, an indium nitride, and an aluminum nitride and which is high crystallinity not more than 100 seconds as half width of the rocking curve of the X-ray diffraction line from the lattice plane of the Miller Index (002) directly onto the substrate which consists of a sintered compact which comprises an aluminum nitride as the main ingredients, the improvement of quality of a sintered compact will be needed in many cases, such as raising the optical transmissivity of a sintered compact, increasing the aluminum nitride particle size in a sintered compact by performing the firing at high temperature for a long time in manufacture of sintered compact, vaporizing sintering aids and then raising the purity of a sintered compact, etc.

And the crystallinity of the formed single crystal thin film tends to be influenced by thickness or surface smooth nature of a substrate, etc.

However, in this invention, as mentioned above, the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed beforehand on the substrate which consists of a sintered compact which comprises an aluminum nitride as the main ingredients, then by forming the single crystal thin film which comprises as the main ingredients at least one or more materials selected from a gallium nitride, an indium nitride, and an aluminum nitride further on this thin film which has at least one of the crystallized states selected from a single crystal, an amorphous state, a polycrystal, and an orientated polycrystal, as this single crystal thin film what is higher crystallinity is easy to be obtained with not too much influence by the quality of these sintered compacts, such as the optical permeability of a sintered compact which comprises an aluminum nitride as the main ingredients used as a substrate, the size of particle of a sintered compact, and composition or purity of this sintered compact, etc., or by thickness of a substrate, surface smooth nature of a substrate, existence of the conduction via in a substrate, etc. or even if influenced.

That is, in this invention, the sintered compact which comprises an aluminum nitride as the main ingredients can be used as a substrate for forming a single crystal thin film of higher crystallinity, with not being influenced too much by the quality of the material, manufacture conditions, etc., even if influenced.

If saying in other words, it can say that beforehand forming the thin film which has at least one of the crystallized states selected from an amorphous state, a polycrystal, an orientated polycrystal, and a single crystal and which comprises as the main ingredients at least one or more materials selected from a gallium nitride, an indium nitride, and an aluminum nitride on the sintered compact which comprises an aluminum nitride as the main ingredients is effective in raising the crystallinity of the single crystal thin film which comprises as the main ingredients at least one or more materials selected from a gallium nitride, an indium nitride, and an aluminum nitride which is formed furthermore on this thin film which has at least one of the crystallized states selected from an amorphous state, a polycrystal, an orientated polycrystal, and a single crystal etc.

Such an effect may be generated without too much influence by the quality of these sintered compacts, such as the optical permeability of a sintered compact which comprises an aluminum nitride as the main ingredients used as a substrate, the size of particle of a sintered compact, and composition or purity of this sintered compact, etc., or by thickness of a substrate, surface smooth nature of a substrate, existence of the conduction via in a substrate, etc.

Of course, as mentioned above, for example, when what has high optical transmissivity as the sintered compact which comprises an aluminum nitride as the main ingredients, what increased the size of the aluminum nitride particle in a sintered compact by performing the firing at high temperature for a long time in manufacture of the sintered compact, and what vaporized sintering aids and raised the purity of this sintered compact, etc. are used as a substrate, although the single crystal thin film which comprises as the main ingredients at least one or more materials selected from a gallium nitride, an indium nitride, and an aluminum nitride and whose half width of the rocking curve of the X-ray diffraction line from the lattice plane of the Miller Index (002) has not more than 100 seconds can be formed directly on this substrate originally, even when the substrate which consists of such sintered compact which comprises an aluminum nitride as the main ingredients is used, when the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed beforehand on this substrate, then the single crystal thin film which comprises as the main ingredients at least one or more materials selected from a gallium nitride, an indium nitride, and an aluminum nitride is formed furthermore on it,

as for this single crystal thin film, that whose half width of the rocking curve of the X-ray diffraction line from the lattice plane of a Miller Index (002) is at least not more than 100 seconds can form.

If another view is carried out, even if it does not beforehand form the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal, since the single crystal thin film excellent in the above crystallinity which comprises as the main ingredients at least one or more materials selected from a gallium nitride, an indium nitride, and an aluminum nitride can be formed even if it uses what kind of method, it can say that the sintered compact which comprises an aluminum nitride as the main ingredients and in which the single crystal thin film which comprises as the main ingredients at least one or more materials selected from a gallium nitride, an indium nitride, and an aluminum nitride and is the crystallinity of at least not more than 100 seconds as half width of the rocking curve of the X-ray diffraction line from the lattice plane of the Miller Index (002) can be formed directly originally has the characteristic excellent as a substrate for forming a single crystal thin film.

As mentioned above, in this invention, the single crystal thin film which comprises as the main ingredients at least one or more materials selected from a gallium nitride, an indium nitride, and an aluminum nitride can be directly formed on the substrate which consists of a sintered compact which comprises an aluminum nitride as the main ingredients, and the crystallinity of this formed single crystal thin film is high, if the thin film which has at least one of the crystallized states selected from a single crystal, an amorphous state, a polycrystal, and an orientated polycrystal is formed beforehand on the substrate which consists of a sintered compact which comprises an aluminum nitride as the main ingredients, then a single crystal thin film is formed furthermore on this thin film which has at least one of the crystallized states selected from a single crystal, an amorphous state, a polycrystal, and an orientated polycrystal, the crystallinity of this single crystal thin film will become easy to improve further as mentioned above.

In the above-mentioned thin film which comprises as the main ingredients at least one or more materials selected from a gallium nitride, an indium nitride, and an aluminum nitride and which forms beforehand on the substrate which consists of a sintered compact which comprises an aluminum nitride as the main ingredients, if the thin film which has at least one of the crystallized states selected from an amorphous state, a polycrystal, and an orientated polycrystal is used, the effect of raising more the crystallinity of the single crystal thin film which is formed on it is large than a single crystal.

Namely, when the thin film which has at least one of the crystallized states selected from an amorphous state, a polycrystal, and an orientated polycrystal and which comprises as the main ingredients at least one or more materials selected from a gallium nitride, an indium nitride, and an aluminum nitride is formed beforehand on the substrate which consists of a sintered compact which comprises an aluminum nitride as the main ingredients, and the single crystal thin film which comprises as the main ingredients at least one or more materials selected from a gallium nitride, an indium nitride, and an aluminum nitride is formed furthermore on the thin film which has these crystallized states, what is high crystallinity not more than 100 seconds as half width of the rocking curve of the X-ray diffraction line from the lattice plane of the Miller Index (002) of this single crystal thin film is easy to be obtained.

On the other hand, when the single crystal thin film which comprises as the main ingredients at least one or more materials selected from a gallium nitride, an indium nitride, and an aluminum nitride is formed beforehand on the substrate which consists of a sintered compact which comprises an aluminum nitride as the main ingredients, then the single crystal thin film which comprises as the main ingredients at least one or more materials selected from a gallium nitride, an indium nitride, and an aluminum nitride is formed furthermore on that single crystal thin film, as for the half width of the rocking curve of the X-ray diffraction line from the lattice plane of the Miller Index (002) of this single crystal thin film, what is not more than 100 seconds may be obtained, but what is high crystallinity not more than 100 seconds may not necessarily be obtained, what is not less than 100 seconds may be formed, depending on the conditions.

Although the reason is not necessarily clear, usually, since the surface smooth nature of the single crystal thin film in the condition of having formed directly on the substrate which consists of a sintered compact which comprises an aluminum nitride as the main ingredients is smaller (surface roughness is larger) than the thin film which has the crystallized state of an amorphous state, a polycrystal, and an orientated polycrystal in the condition of having formed on the substrate directly in many cases, probably, it is easy to produce the fine unevenness which exists in such substrate surface, therefore, this inventor is surmising that it is to become easy to produce distortion in the crystal orientation of a single crystal thin film which grows on it depending on formation conditions.

In this invention, if the thin film which has at least one of the crystallized states selected from an amorphous state, a polycrystal, and an orientated polycrystal is formed in the thin film which has at least one of the crystallized states selected from a single crystal, an amorphous state, a polycrystal, and an orientated polycrystal which is formed beforehand on the substrate which consists of a sintered compact which comprises an aluminum nitride as the main ingredients, then a single crystal thin film will be formed furthermore on these thin films, since the single crystal thin film which is excellent with surface smooth nature will be easy to be obtained, it is desirable.

That is, while the average surface roughness Ra of the single crystal thin film which is formed furthermore on this single crystal thin film usually tends to become larger than 3 nm when the thin film which is formed beforehand on the substrate which consists of a sintered compact which comprises an aluminum nitride as the main ingredients is a single crystal, the average surface roughness Ra of the single crystal thin film which is formed furthermore on this thin film which has at least one of the crystallized states selected from an amorphous state, a polycrystal, and an orientated polycrystal usually tends to become not more than 3 nm when the thin film which is formed beforehand on the substrate which consists of a sintered compact which comprises an aluminum nitride as the main ingredients is what has at least one of the crystallized states selected from an amorphous state, a polycrystal, and an orientated polycrystal.

And, if the thin film which has orientated polycrystalline state is formed in the thin film which has at least one of the crystallized states selected from a single crystal, an amorphous state, a polycrystal, and an orientated polycrystal which is formed beforehand on the substrate which consists of a sintered compact which comprises an aluminum nitride as the main ingredients, then a single crystal thin film will be formed furthermore on this orientated polycrystalline thin film, since the single crystal thin film which is furthermore excellent in surface smooth nature will be easy to be obtained, it is desirable.

That is, while the average surface roughness Ra of the single crystal thin film which is formed furthermore on this amorphous thin film and this polycrystalline thin film usually tends to become larger than 2 nm when the thin film which is formed beforehand on the substrate which consists of a sintered compact which comprises an aluminum nitride as the main ingredients is an amorphous thin film and a polycrystalline thin film, when the thin film which is formed beforehand on the substrate which consists of a sintered compact which comprises an aluminum nitride as the main ingredients is an orientated polycrystal, the average surface roughness Ra of the single crystal thin film which is formed furthermore on this orientated polycrystalline thin film tends to become at least not more than 2 nm, usually tends to become not more than 1.5 nm, furthermore what is not more than 1.0 nm is also comparatively easy to be obtained.

Thus, if the single crystal thin film of not more than Ra 2 nm is used as a part of film layer which constitutes a light emitting device etc. as it is, or if a light emitting device etc. is formed on it by using the thin film substrate in which the single crystal thin film of not more than Ra 2 nm is formed, it is effective in the ability to manufacture that whose characteristics, such as luminous efficiency, are more excellent.

As mentioned above, it explained that it is more desirable to use the thin film which has at least one of the crystallized states selected from an amorphous state, a polycrystal, and an orientated polycrystal rather than a single crystal in the thin film which comprises as the main ingredients at least one or more materials selected from a gallium nitride, an indium nitride, and an aluminum nitride which is formed beforehand on the substrate which consists of a sintered compact which comprises an aluminum nitride as the main ingredients.

Moreover in this invention, it is more desirable to use an orientated polycrystalline thin film in the thin film which has at least one of the crystallized states selected from an amorphous state, a polycrystal, and an orientated polycrystal and which comprises as the main ingredients at least one or more materials selected from a gallium nitride, an indium nitride, and an aluminum nitride and is formed beforehand on the substrate which consists of a sintered compact which comprises an aluminum nitride as the main ingredients.

The reason is as mentioned above, if the thin film which comprises as the main ingredients at least one or more materials selected from a gallium nitride, an indium nitride, and an aluminum nitride which is formed beforehand on the substrate which consists of a sintered compact which comprises an aluminum nitride as the main ingredients is an orientated polycrystal, it is easy to obtain what is superior to the thin film of an amorphous state and a polycrystalline state as the surface smooth nature of the single crystal thin film which is formed furthermore on it, it is easy to acquire what is superior to the crystallinity of this single crystal thin film.

Usually, at least, when the thin film of an orientated polycrystal which comprises as the main ingredients at least one or more materials selected from a gallium nitride, an indium nitride, and an aluminum nitride is formed beforehand on this substrate by using the same substrate which consists of a sintered compact which comprises an aluminum nitride as the main ingredients, it is easy to obtain what excelled what is amorphous and polycrystal in the thin film formed beforehand as the crystallinity of the single crystal thin film formed furthermore on this orientated polycrystalline thin film.

For example, when producing the light emitting device by the thin film which comprises as the main ingredients at least one or more materials selected from a gallium nitride, an indium nitride, and an aluminum nitride and which grew epitaxially on the thin film substrate in which the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal was formed beforehand on the substrate which consists of a sintered compact which comprises an aluminum nitride as the main ingredients, or when producing the light emitting device by the thin film which comprises as the main ingredients at least one or more materials selected from a gallium nitride, an indium nitride, and an aluminum nitride and which grew epitaxially on the thin film substrate in which the single crystal thin film which comprises as the main ingredients at least one or more materials selected from a gallium nitride, an indium nitride, and an aluminum nitride was formed furthermore on the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal was formed beforehand on the substrate which consists of a sintered compact which comprises an aluminum nitride as the main ingredients, etc., as the thin film formed beforehand what has at least one of the crystallized states selected from an amorphous state, a polycrystal, and an orientated polycrystal is superior to a single crystal, it is easy to obtain what is more excellent in luminous efficiency etc., as the thin film formed beforehand an orientated polycrystal is superior to what has at least one of the crystallized states selected from an amorphous state and a polycrystal, it is easy to obtain what is still more excellent in luminous efficiency etc.

Such an effect is same, not only when using as a substrate the sintered compact which comprises an aluminum nitride as the main ingredients but also when using as a substrate the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc.

That is, when the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed beforehand on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then the single crystal thin film which comprises as the main ingredients at least one or more materials selected from a gallium nitride, an indium nitride, and an aluminum nitride is formed furthermore on it, not only that whose half width of the rocking curve of the X-ray diffraction line from the lattice plane of a Miller Index (002) is at least not more than 300 seconds can be formed but also what is high crystallinity not more than 200 seconds can be formed furthermore, as this single crystal thin film.

In such thin film constitution, when the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed beforehand on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed furthermore on it, thus the substrate in which the thin film of a total of two layers was formed is prepared, then the single crystal thin film which comprises as the main ingredients at least one or more materials selected from a gallium nitride, an indium nitride, and an aluminum nitride is formed furthermore on it, not only that whose half width of the rocking curve of the X-ray diffraction line from the lattice plane of a Miller Index (002) is at least not more than 300 seconds can be formed but also what is high crystallinity not more than 200 seconds can be formed furthermore, as the single crystal thin film which is formed in the 2nd layer or in the 3rd layer.

Such an effect is also acquired similarly, not only when beforehand forming only one layer or two layers of thin films which comprise as the main ingredients at least one or more materials selected from a gallium nitride, an indium nitride, and an aluminum nitride and which has at least one of the crystallized states selected from a single crystal, an amorphous state, a polycrystal, and an orientated polycrystal on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., but also when using what formed beforehand a total of three or more layers of thin films as a substrate.

Namely, when the single crystal thin film which comprises as the main ingredients at least one or more materials selected from a gallium nitride, an indium nitride, and an aluminum nitride was formed furthermore on the substrate which consists of various sintered compacts which formed beforehand three or more layers of thin films comprising at least one or more materials selected from a gallium nitride, an indium nitride, and an aluminum nitride as the main ingredients and having at least one of the crystallized states selected from a single crystal, an amorphous state, a polycrystal, and an orientated polycrystal, forming beforehand three or more layers of thin films having at least one of the crystallized states selected from a single crystal, an amorphous state, a polycrystal, and an orientated polycrystal, and which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., not only that whose half width of the rocking curve of the X-ray diffraction line from the lattice plane of a Miller Index (002) is at least not more than 300 seconds can be formed but also what is high crystallinity not more than 200 seconds can be formed furthermore, as this single crystal thin film.

As mentioned above, for example, if it is going to form a single crystal thin film which is high crystallinity not more than 200 seconds as half width of the rocking curve of the X-ray diffraction line from the lattice plane of the Miller Index (002) directly on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., it is usually difficult in many cases by the ideas, such as, for example, to enlarge size of the crystal grain in a sintered compact, to use the sintered compact of an optical permeability, to raise the surface smooth nature of a substrate, and to increase the thickness of the single crystal thin film, etc.

However, in this invention, as mentioned above, the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is formed beforehand on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then by forming the single crystal thin film which comprises as the main ingredients at least one or more materials selected from a gallium nitride, an indium nitride, and an aluminum nitride further on it, as this single crystal thin film what is higher crystallinity is easy to be obtained with not too much influence by the quality of these sintered compacts, such as the size of the crystal grain of the sintered compact used as a substrate, the surface smooth nature of a substrate, and the thickness of a thin film etc., or even if influenced.

That is, in this invention, when using as a substrate this sintered compact, the single crystal thin film which has higher crystallinity is producible without being influenced too much by the material of the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., or the quality of a substrate, such as surface smooth nature etc., or even if it was influenced.

As mentioned above, in this invention, the single crystal thin film which comprises as the main ingredients at least one or more materials selected from a gallium nitride, an indium nitride, and an aluminum nitride can be directly formed on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., and what is high as crystallinity of this single crystal thin film can form, as mentioned above, if the thin film which has at least one of the crystallized states selected from a single crystal, an amorphous state, a polycrystal, and an orientated polycrystal is formed beforehand on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then a single crystal thin film is formed furthermore on this substrate, the crystallinity of this single crystal thin film will become easy to improve further.

In the above-mentioned thin film which comprises as the main ingredients at least one or more materials selected from a gallium nitride, an indium nitride, and an aluminum nitride and which is formed beforehand on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., if the thin film which has at least one of the crystallized states selected from an amorphous state, a polycrystal, and an orientated polycrystal is used, the effect of raising more the crystallinity of the single crystal thin film which is formed on this thin film is large than a single crystal, it is more desirable.

That is, when the thin film which has at least one of the crystallized states selected from an amorphous state, a polycrystal, and an orientated polycrystal and which comprises as the main ingredients at least one or more materials selected from a gallium nitride, an indium nitride, and an aluminum nitride, is formed beforehand on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then the single crystal thin film which comprises as the main ingredients at least one or more materials selected from a gallium nitride, an indium nitride, and an aluminum nitride is formed furthermore on it, what is high crystallinity not more than 200 seconds as half width of the rocking curve of the X-ray diffraction line from the lattice plane of the Miller Index (002) of this single crystal thin film is easy to be obtained.

On the other hand, when the single crystal thin film which comprises as the main ingredients at least one or more materials selected from a gallium nitride, an indium nitride, and an aluminum nitride is formed beforehand on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then the single crystal thin film which comprises as the main ingredients at least one or more materials selected from a gallium nitride, an indium nitride, and an aluminum nitride is formed furthermore on it, what is high crystallinity not more than 200 seconds as half width of the rocking curve of the X-ray diffraction line from the lattice plane of the Miller Index (002) of this single crystal thin film may not necessarily be obtained, it is because what is not less than 200 seconds may be formed, depending on conditions.

Although the reason is not necessarily clear, usually, since the surface smooth nature of the single crystal thin film in the condition of having formed directly on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is smaller (surface roughness is larger) than the thin film which has at least one of the crystallized states selected from an amorphous state, a polycrystal, and an orientated polycrystal in the condition of having formed on the substrate in many cases, probably, it is easy to produce the fine unevenness which exists in such substrate surface, therefore, this inventor is surmising that it is to become easy to produce distortion in the crystal orientation of a single crystal thin film which grows on it depending on formation conditions.

Moreover, in the above-mentioned thin film which is formed beforehand on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., if the thin film which has the crystallized state of an orientated polycrystal will be used, since the effect of raising more the crystallinity of the single crystal thin film which is formed on it is large than an amorphous state and a polycrystal, it is still more desirable.

That is, if the substrate which formed beforehand the thin film comprising at least one or more materials selected from a gallium nitride, an indium nitride, and an aluminum nitride as the main ingredients and having the crystallized state of an orientated polycrystal onto the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is used, what is high crystallinity not more than 150 seconds as half width of the rocking curve of the X-ray diffraction line from the lattice plane of the Miller Index (002) of the single crystal thin film formed on it is easy to be obtained.

On the other hand, if the substrate which formed beforehand the thin film comprising at least one or more materials selected from a gallium nitride, an indium nitride, and an aluminum nitride as the main ingredients and having the crystallized state of an amorphous state and a polycrystal onto the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is used, what is high crystallinity not more than 150 seconds as half width of the rocking curve of the X-ray diffraction line from the lattice plane of the Miller Index (002) of the single crystal thin film formed on it may not necessarily be obtained.

Although the reason is not necessarily clear, usually, since the surface smooth nature of the amorphous thin film and the polycrystalline thin film in the condition of having formed directly on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is smaller (surface roughness is larger) than the orientated polycrystalline thin film in the condition of having formed directly on the substrate in many cases, probably, it is easy to produce the fine unevenness which exists in such substrate surface, therefore, this inventor is surmising that it becomes easy to produce distortion in the crystal orientation of a single crystal thin film which grows on it depending on formation conditions.

For example, when producing the light emitting device by the thin film which comprises as the main ingredients at least one or more materials selected from a gallium nitride, an indium nitride, and an aluminum nitride which grew epitaxially on the thin film substrate in which the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal was formed beforehand on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., or when producing the light emitting device by the thin film which comprises as the main ingredients at least one or more materials selected from a gallium nitride, an indium nitride, and an aluminum nitride which grew epitaxially on the thin film substrate which is obtained by forming the single crystal thin film which comprises as the main ingredients at least one or more materials selected from a gallium nitride, an indium nitride, and an aluminum nitride on the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is directly formed beforehand on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., what has at least one of the crystallized states selected from an amorphous state, a polycrystal, and an orientated polycrystal is superior to a single crystal as the thin film formed beforehand, it is easy to obtain what is more excellent in luminous efficiency etc., as the thin film formed beforehand an orientated polycrystal is superior to what has at least one of the crystallized states selected from an amorphous state and a polycrystal, it is easy to obtain what is still more excellent in luminous efficiency etc.

As mentioned above, if the thin film which has at least one of the crystallized states selected from a single crystal, an amorphous state, a polycrystal, and an orientated polycrystal and which comprises as the main ingredients at least one or more materials selected from a gallium nitride, an indium nitride, and an aluminum nitride is formed beforehand on the substrate which consists of a sintered compact which comprises an aluminum nitride as the main ingredients or various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then the single crystal thin film which comprises as the main ingredients at least one or more materials selected from a gallium nitride, an indium nitride, and an aluminum nitride is formed furthermore on it, the single crystal thin film excellent in crystallinity can form easily.

In this invention, in the substrate which consists of a sintered compact which comprises an aluminum nitride as the main ingredients, and in the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., a single crystal thin film which comprises as the main ingredients at least one or more materials selected from a gallium nitride, an indium nitride, and an aluminum nitride can be formed directly as mentioned above, and the crystallinity of a single crystal thin film directly formed on these substrates is influenced by the composition of the sintered compact used as a substrate, optical permeability of a sintered compact, size of the crystal grain in a sintered compact, or surface smooth nature of a substrate, etc.

However, on the other hand, as mentioned above, if the thin film which comprises as the main ingredients at least one or more materials selected from a gallium nitride, an indium nitride, and an aluminum nitride and which has at least one of the crystallized states selected from an amorphous state, a polycrystal, an orientated polycrystal, and a single crystal is formed beforehand on the substrate which consists of a sintered compact which comprises an aluminum nitride as the main ingredients and various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then the single crystal thin film which comprises as the main ingredients at least one or more materials selected from a gallium nitride, an indium nitride, and an aluminum nitride is formed furthermore on it, it becomes possible to form a crystalline higher single crystal thin film comparatively easily with not too much influence by the surface smooth nature of the substrate which consists of a sintered compact which comprises an aluminum nitride as the main ingredients and various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., and by the size of the crystal grain in the sintered compact etc., or even if influenced.

In this invention, if the thin film which comprises as the main ingredients at least one or more materials selected from a gallium nitride, an indium nitride, and an aluminum nitride and which has at least one of the crystallized states selected from an amorphous state, a polycrystal, an orientated polycrystal, and a single crystal is formed beforehand as mentioned above, even if the smooth nature of the surface of a substrate which consists of a sintered compact which comprises an aluminum nitride as the main ingredients and various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is in what kind of state, such as a state of as-fired (as-fire), a state of lap polish, a state of specular surface polish, and a state of blast polish, the single crystal thin film excellent in crystallinity can form easily in this substrate.

Namely, even if smooth nature of the surface of a substrate is small, namely, it is a substrate with large average surface roughness Ra, if the thin film which comprises as the main ingredients at least one or more materials selected from a gallium nitride, an indium nitride, and an aluminum nitride and which has at least one of the crystallized states selected from an amorphous state, a polycrystal, an orientated polycrystal, and a single crystal is formed beforehand as mentioned above, the single crystal thin film excellent in crystallinity can form easily in this substrate.

Usually, in the case of the substrate which consists of a sintered compact which comprises an aluminum nitride as the main ingredients, although the single crystal thin film which comprises as the main ingredients at least one or more materials selected from a gallium nitride, an indium nitride, and an aluminum nitride cannot be formed directly on a substrate whose average surface roughness Ra is larger than 2000 nm, for example, as-fired(as-fire) surface, or the surface which processed such as lap polish, or blast polish, etc. in many cases, if the thin film which comprises as the main ingredients at least one or more materials selected from a gallium nitride, an indium nitride, and an aluminum nitride and which has at least one of the crystallized states selected from an amorphous state, a polycrystal, an orientated polycrystal, and a single crystal is formed beforehand on this substrate as mentioned above, even if it is the substrate whose average surface roughness Ra is larger than 2000 nm, a single crystal thin film excellent in crystallinity not more than 300 seconds as half width of the rocking curve of the X-ray diffraction line from the lattice plane of a Miller Index (002) of the single crystal thin film which comprises as the main ingredients at least one or more materials selected from a gallium nitride, an indium nitride, and an aluminum nitride can be formed comparatively easily.

In the case of the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., although the single crystal thin film which comprises as the main ingredients at least one or more materials selected from a gallium nitride, an indium nitride, and an aluminum nitride cannot be formed directly on a substrate whose average surface roughness Ra is larger than 1000 nm, for example, as-fired (as-fire) surface, or the surface which processed such as lap polish, or blast polish, etc. in many cases, if the thin film which comprises as the main ingredients at least one or more materials selected from a gallium nitride, an indium nitride, and an aluminum nitride and which has at least one of the crystallized states selected from an amorphous state, a polycrystal, an orientated polycrystal, and a single crystal is formed beforehand on this substrate on this substrate as mentioned above, even if it is the substrate whose average surface roughness Ra is larger than 1000 nm, a single crystal thin film excellent in crystallinity not more than 300 seconds as half width of the rocking curve of the X-ray diffraction line from the lattice plane of a Miller Index (002) of the single crystal thin film which comprises as the main ingredients at least one or more materials selected from a gallium nitride, an indium nitride, and an aluminum nitride can be formed comparatively easily.

In this invention, as for the crystal grain in the various sintered compacts which are used as a substrate and which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., for example, what was sintered without making it grow up with about 0.5 μm, namely,in the same state as the size of the particle of raw material powder, can also use, the single crystal thin film which comprises as the main ingredients at least one or more materials selected from a gallium nitride, an indium nitride, and an aluminum nitride and has the crystallinity not more than 3600 seconds as half width of the rocking curve of the X-ray diffraction line from the lattice plane of the Miller Index (002) can be formed directly on such substrate. Usually, the sintered compact which consists of crystal grain of an average of not less than 1 μm is used as a substrate.

That is, when using as a substrate the various sintered compacts which consist of the crystal grain with an average not less than 1 μm and which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., the single crystal thin film which comprises as the main ingredients at least one or more materials selected from a gallium nitride, an indium nitride, and an aluminum nitride and has the crystallinity not more than 3600 seconds as half width of the rocking curve of the X-ray diffraction line from the lattice plane of the Miller Index (002) can be formed directly on this substrate.

If the size of the crystal grain inside the above-mentioned various sintered compacts which comprise a ceramic material as the main ingredients increases, the crystallinity of the thin film which comprises as the main ingredients at least one or more materials selected from a gallium nitride, an indium nitride, and an aluminum nitride and is formed on this substrate will tend to improve.

That is, in the sintered compact which has an average of not less than 5 μm as the size of the crystal grain contained in the inside of the above-mentioned various sintered compacts which comprise a ceramic material as the main ingredients, what has the crystallinity, such that the half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and is formed on the substrate is not more than 2000 seconds, can be formed directly.

Moreover, in the sintered compact which has an average of not less than 8 μm as the size of the crystal grain which is contained in the inside of the above-mentioned various sintered compacts which comprise a ceramic material as the main ingredients, what is good crystallinity, such that the half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and is formed on the substrate is not more than 1000 seconds, can be formed directly.

Moreover, in the sintered compact which has an average of not less than 15 μm as the size of the crystal grain which is contained in the inside of the above-mentioned various sintered compacts which comprise a ceramic material as the main ingredients, what is better crystallinity, such that the half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and is formed on the substrate is not more than 300 seconds, can be formed directly.

Moreover, in the sintered compact which has an average of not less than 25 μm as the size of the crystal grain which is contained in the inside of the above-mentioned various sintered compacts which comprise a ceramic material as the main ingredients, what is still better crystallinity, such that the half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride and is formed on the substrate is not more than 240 seconds, can be formed directly.

By the way, the size of the crystal grain contained inside the above-mentioned various sintered compacts which comprise a ceramic material as the main ingredients is an average size, not only what is in the condition that the crystal grain contained is equal to equally near magnitude but also what has the irregular size of a crystal grain and what has the distorted form of a crystal grain and even if what contains the crystal grains of which one side is several μm and other one side is what grew up greatly into about ten or more μm, such as needle-like or board-like, such as β-Si₃N₄ particles etc, for example, in the sintered compact which comprises a silicon nitride as the main ingredients can use satisfactorily, in this invention.

The size of the crystal grain contained inside the above-mentioned various sintered compacts which comprise a ceramic material as the main ingredients is controllable by using firing conditions whether alone or together, such as raising firing temperature or lengthening firing time.

However, in this invention, as mentioned above, if the thin film which has at least one of the crystallized states selected from an amorphous state, a polycrystal, an orientated polycrystal, and a single crystal and which comprises as the main ingredients at least one or more materials selected from a gallium nitride, an indium nitride, and an aluminum nitride is formed beforehand on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then the single crystal thin film which comprises as the main ingredients at least one or more materials selected from a gallium nitride, an indium nitride, and an aluminum nitride is formed furthermore on it, what is comparatively good crystallinity of this single crystal thin film is producible with not too much influence by the size of the crystal grain in the above-mentioned sintered compact which comprises various ceramic materials as the main ingredients, and the surface smooth nature of the substrate which consists of this sintered compact, etc.

As mentioned above, by using the substrate which formed the thin film which comprises as the main ingredients at least one or more materials selected from a gallium nitride, an indium nitride, and an aluminum nitride and has at least one of the crystallized states selected from an amorphous state, a polycrystal, an orientated polycrystal, and a single crystal etc., then the single crystal thin film which has good crystallinity is formed on it, it is possible to improve the crystallinity of this single crystal thin film further in this invention.

That is, it can be further improved by improvement of the surface smooth nature of the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc.

Speaking more concretely, when the average surface roughness Ra of the substrate using the above-mentioned various sintered compacts which comprise a ceramic material is larger than 10 nm, as for the orientated polycrystalline thin film which comprises as the main ingredients at least one or more materials selected from a gallium nitride, an indium nitride, and an aluminum nitride formed beforehand on this substrate, the half width of the rocking curve of the X-ray diffraction line from the lattice plane of a Miller Index (002) tends to become larger than 10000 seconds, the single crystal thin film formed on the orientated polycrystalline thin film which has such crystallinity has the tendency for the half width of the rocking curve of the X-ray diffraction line from the lattice plane of a Miller Index (002) to tend to become larger than 150 seconds.

However, when the average surface roughness Ra of the substrate which consists of the above-mentioned various sintered compacts which comprise a ceramic material as the main ingredients is not more than 10 nm, the half width of the rocking curve of the X-ray diffraction line from the lattice plane of the Miller Index (002) of the above-mentioned orientated polycrystalline thin film formed beforehand on this substrate tends to become not more than 10000 seconds, and the half width of the rocking curve of the X-ray diffraction line from the lattice plane of the Miller Index (002) of the single crystal thin film formed on the orientated polycrystalline thin film with such crystallinity has the tendency easy to become not more than 150 seconds.

Moreover, when the average surface roughness Ra of the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is not more than 5 nm, it is easy to become not more than 8000 seconds as half width of the rocking curve of the X-ray diffraction line from the lattice plane of the Miller Index (002) of the above-mentioned orientated polycrystalline thin film formed beforehand on this substrate, the half width of the rocking curve of the X-ray diffraction line from the lattice plane of the Miller Index (002) of the single crystal thin film formed on the orientated polycrystalline thin film of such crystallinity has the tendency easy to become not more than 130 seconds, and usually tends to become not more than 120 seconds.

When the average surface roughness Ra of the substrate which consists of the above-mentioned various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is not more than 5 nm, among the thin films which comprise as the main ingredients at least one or more materials selected from a gallium nitride, an indium nitride, and an aluminum nitride formed beforehand on this substrate, in the case of what has at least one of the crystallized states selected from an amorphous state, a polycrystal, and a single crystal, although the half width of the rocking curve of the X-ray diffraction line from the lattice plane of the Miller Index (002) of the single crystal thin film formed on it has the tendency easy to become not more than 130 seconds, the crystallinity of the single crystal thin film formed furthermore on it tends to become what is more excellent by being the crystallized state of an orientated polycrystal as the thin film formed beforehand on a substrate as mentioned above.

In this invention, if the substrate which formed the thin film which has at least one of the crystallized states selected from an amorphous state, a polycrystal, and an orientated polycrystal is used among the thin film which has at least one of the crystallized states selected from a single crystal, an amorphous state, a polycrystal, and an orientated polycrystal and which beforehand forms on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., since more excellent thing is usually easy to be obtained as surface smooth nature of the single crystal thin film which forms on it, it is desirable.

While the average surface roughness Ra of the single crystal thin film furthermore formed on it is usually larger than 3 nm when the thin film formed beforehand on a substrate is a single crystal, the average surface roughness Ra of the single crystal thin film formed on it is usually at least not more than 3 nm when the thin film formed beforehand on a substrate is what has at least one of the crystallized states selected from an amorphous state, a polycrystal, and an orientated polycrystal. When the thin film formed beforehand on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is an orientated polycrystal, since what was usually most excellent as surface smooth nature of the single crystal thin film formed on it is easy to be obtained, it is still more desirable.

Although the average surface roughness Ra of the single crystal thin film which is formed on it tends to become larger than 2 nm usually when the thin film which is formed beforehand on this substrate is an amorphous state and a polycrystal, when the thin film which is formed beforehand on the substrate is an orientated polycrystal, the average surface roughness Ra of the single crystal thin film which is formed furthermore on it tends to become at least not more than 2 nm, usually tends to become not more than 1.5 nm, furthermore what is not more than 1.0 nm is also comparatively easy to be obtained.

Thus, if the single crystal thin film of not more than Ra 2 nm is used as a part of film layer which constitutes the electric devices such as a light emitting device etc. as it is, or if the electric devices such as a light emitting device etc. are formed on it by using the substrate in which the single crystal thin film of not more than Ra 2 nm is formed, it is effective in the ability to manufacture that whose characteristics, such as luminous efficiency, are more excellent.

When forming the light emitting device on the substratrin which such single crystal thin film of high crystallinity was formed, or when using directly this single crystal thin film of high crystallinity as a part of thin films which constitute a light emitting device, since the luminous efficiency of the formed light emitting device tends to increase, it is desirable.

If the thin film which which consists of at least one or more materials selected from a gallium nitride, an indium nitride, and an aluminum nitride and which has at least one of the crystallized states selected from a single crystal, an amorphous state, a polycrystal, and an orientated polycrystal is formed beforehand on the substrate which consists of a sintered compact which comprises an aluminum nitride as the main ingredients or the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then the single crystal thin film which comprises as the main ingredients at least one or more materials selected from a gallium nitride, an indium nitride, and an aluminum nitride will be formed furthermore on it, it becomes easy to control C axis crystal orientation of this single crystal thin film in a direction perpendicular to a substrate surface, or the direction parallel to a substrate surface.

As for the X-ray diffraction pattern which this single crystal thin film which is formed in the direction where C axis crystal orientation of this single crystal thin film is perpendicular to a substrate surface shows, the diffraction line from the diffracting plane of a Miller Index (002) appears, and the diffraction line from the diffracting plane of a Miller Index (100) does not appear.

Since, as for the X-ray diffraction pattern which this single crystal thin film which is formed in the direction where C axis crystal orientation of this single crystal thin film is parallel to a substrate surface shows, the diffraction line from the diffracting plane of a Miller Index (100) appears and the diffraction line from the diffracting plane of a Miller Index (002) does not appear, the azimuth of this single crystal thin film can be distinguished easily.

As mentioned above, in this invention, if by using the substrate in which at least one or more layers of a thin film which consists of at least one or more materials selected from a gallium nitride, an indium nitride, and an aluminum nitride and which has at least one of the crystallized states selected from a single crystal, an amorphous state, a polycrystal, and an orientated polycrystal was formed beforehand on the substrate which consists of a sintered compact which comprises an aluminum nitride as the main ingredients and various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an. aluminum oxide etc., then the single crystal thin film will be formed on the substrate on which this thin film is formed, the crystallinity of this single crystal thin film may improve further.

The reason which this phenomenon produces will be explained concretely below by using the sintered compact which comprises an aluminum nitride as the main ingredients as an example.

That is, when forming directly the single crystal thin film which consists of at least one or more materials selected from a gallium nitride, an indium nitride, and an aluminum nitride on the sintered compact which comprises an aluminum nitride as the main ingredients, the crystallinity of the formed single crystal thin film tends to be influenced by the quality of the material of this sintered compact which comprises an aluminum nitride as the main ingredients, such as optical transmissivity of the sintered compact which comprises an aluminum nitride as the main ingredients, chemical composition, and size of a crystal grain, etc.

For example, usually including an aluminum nitride ingredient not less than 50 volume % is important when forming a good single crystal thin film directly as a sintered compact which comprises an aluminum nitride as the main ingredients.

If there is a fewer content of aluminum nitride ingredient than 50 volume %, since the direct formation of the good single crystal thin film is hard to be carried out or the thin film of a polycrystalline state is easy to be formed, it may not be desirable.

On the other hand, if a single crystal thin film is formed on the substrate which formed beforehand this thin film using the substrate which consists of a sintered compact which comprises an aluminum nitride as the main ingredients and which formed beforehand the thin film which has at least one of the crystallized states selected from a single crystal, an amorphous state, a polycrystal, and an orientated polycrystal, the crystallinity of the formed single crystal thin film has the feature of becoming hard to be influenced by the quality of the material of the sintered compact which comprises as the main ingredients, such as optical transmissivity of the sintered compact which comprises an aluminum nitride as the main ingredients, chemical composition, and size of a crystal grain, etc.

That is, for example, even if it is the thing whose content of the aluminum nitride ingredient of the sintered compact which comprises an aluminum nitride as the main ingredients is smaller than 50 volume %, if the thing whose thin film which has at least one of the crystallized states selected from a single crystal, an amorphous state, a polycrystal, and an orientated polycrystal was formed beforehand on it is used as a substrate, the thin film which is formed on it and which consists of at least one or more materials selected from a gallium nitride, an indium nitride, and an aluminum nitride is becoming hard to be a polycrystal, the single crystal thin film which is comparatively excellent in crystallinity can form.

As for such phenomenon, even if one or two or more doping ingredients which give N-type semiconductor characteristics such as Si, Ge, Se, Te, O, and P type semiconductor characteristics such as Mg, Be, Ca, Zn, Cd, C, etc. into the thin film of various crystallized states, such as a single crystal, an amorphous state, a polycrystal, and an orientated polycrystal, are contained, the same effect will be obtained.

Experimentally, the thin film which has at least one of the crystallized states selected from a single crystal, an amorphous state, a polycrystal, and an orientated polycrystal can be formed beforehand on the sintered compact which comprises an aluminum nitride as the main ingredients and contains the aluminum nitride ingredient not less than 20 volume % at least, if what formed this thin film is used as a substrate, it was confirmed that the single crystal thin film which consists of at least one or more materials selected from a gallium nitride, an indium nitride, and an aluminum nitride and has the crystallinity not more than 300 seconds as half width of the rocking curve of the X-ray diffraction line from the lattice plane of a Miller Index (002) can be formed on it.

Moreover, the thin film which has at least one of the crystallized states selected from a single crystal, an amorphous state, a polycrystal, and an orientated polycrystal can be formed beforehand on the sintered compact which comprises an aluminum nitride as the main ingredients and contains the aluminum nitride ingredient not less than 50 volume % at least, if what formed this thin film is used as a substrate, it was confirmed that the single crystal thin film which consists of at least one or more materials selected from a gallium nitride, an indium nitride, and an aluminum nitride and has the crystallinity not more than 240 seconds as half width of the rocking curve of the X-ray diffraction line from the lattice plane of a Miller Index (002) can be formed on it.

In the above-mentioned sintered compact which comprises an aluminum nitride as the main ingredients and contains the aluminum nitride ingredient not less than 20 volume %, as ingredient other than an aluminum nitride, for example, the thing which contains at least one of ingredients selected from a rare earth element and an alkaline earth metal not more than 80 volume % by oxide conversion or contains at least one of ingredients selected from Mo, W, V, Nb, Ta, Ti, carbon not more than 80 volume % by element conversion, or ALON not more than 80% can be used suitably.

In the sintered compact which comprises an aluminum nitride as the main ingredients and contains an aluminum nitride ingredient not less than 20 volume %, the thing whose oxygen content is not more than 30 weight % by element conversion can be used suitably.

If an oxygen content is not more than 30 weight %, the sintered compact which comprises an aluminum nitride as the main ingredients and contains ALON not more than 80% will be easy to be obtained.

And, in the sintered compact which comprises an aluminum nitride as the main ingredients and contains an aluminum nitride ingredient not less than 50 volume %, what contains each ingredient other than aluminum nitride not more than 50 volume % as mentioned above and what contains at least one of ingredients selected from an alkali metal and silicon not more than 50 volume % by oxide conversion in addition to this can also be used suitably.

Among those, it is preferred to use the sintered compact which comprises an aluminum nitride as the main ingredients and contains an alkali metal not more than 30 volume % by oxide conversion.

The sintered compact which comprises an aluminum nitride as the main ingredients and which contains the transition metals other than a rare earth element and Mo, W, V, Nb, Ta, and Ti, for example, at least one of ingredients selected from iron, nickel, chromium, manganese, zirconium, hafnium, cobalt, copper, and zinc not more than 80 weight % by element conversion can also be used suitably as a substrate.

In this invention, although the weight percent (weight %) by element conversion has been shown as the content of each ingredient of the above-mentioned transition-metals other than a rare earth element and Mo, W, V, Nb and Ta, and Ti, for example, iron, nickel, chromium, manganese, zirconium, hafnium, cobalt, copper, and zinc, it can recalculate from the density of these ingredients to volume percentage (volume %) easily.

As mentioned above, in the substrate which consists of a sintered compact which comprises as the main ingredients a zirconium oxide (ZrO₂), a magnesium oxide (MgO), and a magnesium aluminate (MgAl₂O₄), etc., it is difficult to form directly the single crystal thin film which comprises as the main ingredients at least one or more materials selected from a gallium nitride, an indium nitride, and an aluminum nitride in many cases.

However, it was found out that the thin film can be formed directly on the above-mentioned substrate, if it was the thin film which has at least one of the crystallized states selected from an amorphous state, a polycrystal, and an orientated polycrystal and which comprises as the main ingredients at least one or more materials selected from a gallium nitride, an indium nitride, and an aluminum nitride.

Moreover, in this invention, if the thin film which has at least one of the crystallized states selected from an amorphous state, a polycrystal, and an orientated polycrystal and which comprises as the main ingredients at least one or more materials selected from a gallium nitride, an indium nitride, and an aluminum nitride is formed beforehand on these substrates, using as a substrate the above-mentioned sintered compacts which comprise as the main ingredients a zirconium oxide, a magnesium oxide, and a magnesium aluminate, etc., it was also found out that the single crystal thin film which comprises as the main ingredients at least one or more materials selected from a gallium nitride, an indium nitride, and an aluminum nitride and has the crystallinity not more than 3600 seconds as half width of the rocking curve of the X-ray diffraction line from the lattice plane of a Miller Index (002) can be formed on these.

Moreover, various sintered compacts which comprise as the main ingredients a ceramic material, such as a titanium oxide (TiO₂), a barium titanate (BaTiO₃), a lead titanate zirconate (PZT), rare earth oxides such as a yttrium oxide (Y₂O₃), a thorium dioxide (ThO₂), various ferrites (Fe₃O₄, etc.), a mullite (3Al₂O₃.2SiO₂), a forsterite (2MgO.SiO₂), a steatite (MgO.SiO₂), and glass ceramics, can also be used as a substrate, it was found out that the thin film can also be formed directly on this substrate, if it was the thin film which has at least one of the crystallized states selected from an amorphous state, a polycrystal, and an orientated polycrystal and which comprises as the main ingredients at least one or more materials selected from a gallium nitride, an indium nitride, and an aluminum nitride.

Moreover, if what formed beforehand the thin film which has at least one of the crystallized states selected from an amorphous state, a polycrystal, and an orientated polycrystal and which comprises as the main ingredients at least one or more materials selected from a gallium nitride, an indium nitride, and an aluminum nitride is used as a substrate, it was also found out that the single crystal thin film which comprises as the main ingredients at least one or more materials selected from a gallium nitride, an indium nitride, and an aluminum nitride and has the crystallinity not more than 3600 seconds as half width of the rocking curve of the X-ray diffraction line from the lattice plane of a Miller Index (002) can be formed on it.

On the substrate which carried out grinding of the surface by the method of specular surface polish or others and which was made into average surface roughness of not more than 50 nm and consisting of the above-mentioned various sintered compacts which comprise as the main ingredients a ceramic material, such as a zirconium oxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics, if the thin film which has at least one of the crystallized states selected from an amorphous state, a polycrystal, and an orientated polycrystal and which comprises as the main ingredients at least one or more materials selected from a gallium nitride, an indium nitride, and an aluminum nitride is formed beforehand, the single crystal thin film which comprises as the main ingredients at least one or more materials selected from a gallium nitride, an indium nitride, and an aluminum nitride and has the crystallinity not more than 300 seconds as half width of the rocking curve of the X-ray diffraction line from the lattice plane of a Miller Index (002) can be formed on it.

The single crystal thin film which has the crystallinity whose half width of this rocking curve is not more than 200 seconds can be formed on the substrate made into average surface roughness of not more than 10 nm.

And, the single crystal thin film which has the crystallinity whose half width of this rocking curve is not more than 150 seconds can be formed on the substrate made into average surface roughness of not more than 5 nm.

Moreover, the orientated polycrystalline thin film which comprises as the main ingredients at least one or more materials selected from a gallium nitride, an indium nitride, and an aluminum nitride and whose half width of an rocking curve of the X-ray diffraction is not more than 10000 seconds can be formed beforehand on the substrate made into average surface roughness of not more than 10 nm.

Moreover, the orientated polycrystalline thin film which comprises as the main ingredients at least one or more materials selected from a gallium nitride, an indium nitride, and an aluminum nitride and whose half width of an rocking curve of the X-ray diffraction is not more than 8000 seconds can be formed beforehand on the substrate made into average surface roughness of not more than 5 nm.

As the method of further forming the single crystal thin film which comprises as the main ingredients at least one or more materials selected from a gallium nitride, an indium nitride, and an aluminum nitride, after beforehand forming the thin film which consists of at least one or more materials selected from a gallium nitride, an indium nitride, and an aluminum nitride and which has above-mentioned at least one of the crystallized states selected from a single crystal, an amorphous state, a polycrystal, and an orientated polycrystal on the substrate which consists of a sintered compact which comprises an aluminum nitride as the main ingredients and various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., for example, the following can be illustrated.

That is, there are methods, such as the method of forming a single crystal thin film anew after taking out the substrate on which the thin film which has at least one of the crystallized states selected from a single crystal, an amorphous state, a polycrystal, and an orientated polycrystal from a film deposition apparatus, or the method, that is ; where the temperature of a substrate is set up low at first, the thin film of an amorphous is first formed on a substrate, then a substrate is in the condition as it is, the temperature of a substrate is gone up gradually or continuously, and the single crystal thin film is formed gradually or continuously, etc.

The thin film which is formed on the substrate which consists of a sintered compact which comprises an aluminum nitride as the main ingredients or on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., can form not only as single layer but also as the thin film which consists of two or more layers as mentioned above.

As for the above-mentioned substrate which consists of a sintered compact which comprises an aluminum nitride as the main ingredients, and substrate which consists of a sintered compact which comprises various ceramic materials as the main ingredients, the substrate which has a conduction via is also included.

This thin film which is formed as the thin film which consists of two or more layers can be formed also as the same composition or as what consists of an ingredient which is different, respectively, moreover, in the thin film of three or more layers, all can be formed as the same composition, or it can form as a thin film layer in which two or more layers are the same composition and other one or more layers are the different composition, furthermore, it can be formed as thin film layers whose compositions are different altogether.

As for the constitution of the thin film which was formed in two or more layers on the substrate which consists of a sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., not only what has the different composition of each thin film layer but also what has the same crystallized state of each thin film layer or what has the different crystallized state of each thin film layer, for example, a single crystal, an amorphous state, a polycrystal, an orientated polycrystal, etc., can form on the substrate which consists of a sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., as mentioned above.

Namely, in the substrate which consists of a sintered compact which comprises an aluminum nitride as the main ingredients, and in the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., two or more layers of a thin film which comprises as the main ingredients at least one or more materials selected from a gallium nitride, an indium nitride, and an aluminum nitride can be formed, in these thin films which are being constituted with two or more layers, what is any state which is selected from single crystal, amorphous state, polycrystal, and orientated polycrystal at least can be formed without being restricted in each thin film layer.

If there are two thin film layers, there are what consists of two layers in which the crystallized state is same and what consists of each layer in which the crystallized state is different, if what consists of two layers in which the crystallized state is same is illustrated, for example, 1) what consists of two layers in which all of each layer are single crystal state, 2) what consists of two layers in which all of each layer are amorphous, etc., if what consists of each layer in which the crystallized state is different is illustrated, for example, 3) the thin film by the side of a substrate is amorphous and the thin film currently formed on it is single crystal, or 4) the thin film by the side of a substrate is polycrystal and the thin film currently formed on it is single crystal, or 5) the thin film by the side of a substrate is an orientated polycrystal and the thin film currently formed on it is a single crystal, etc.

When the above-mentioned thin film layer consists of two layers, since as the thin film by the side of a substrate what has at least four kinds of crystallized states, such as a single crystal, an amorphous state, a polycrystal, and an orientated polycrystal can be formed, and as the thin film which is formed on it what has at least four kinds of crystallized states, a single crystal, an amorphous state, a polycrystal, and an orientated polycrystal can be formed respectively, two-layer thin film formation which consists of combinations of a total of 16 kinds is possible.

When a thin film layer consists of three layers, for example, what consists of three layers in which the crystallized state is same, what consists of three layers in which the crystallized state is different respectively, what consists of three layers in which the crystallized states of two layers are same and one is different, if what consists of three layers in which the crystallized states are same is illustrated, for example, 1) what consists of three layers in which all of each layer are single crystal state, 2) what consists of three layers in which all of each layer are amorphous, etc., if what consists of three layers in which the crystallized state is different respectively is illustrated, 3) the thin film by the side of a substrate is amorphous and the thin film currently formed on it is polycrystal and the thin film which is being formed on it is single crystal, if what consists of three layers in which the crystallized states of two layers are same and one is different is illustrated, 3) the thin film by the side of a substrate is amorphous and the two layers of the thin films currently formed on it are both single crystal, etc.

When the above-mentioned thin film layer consists of three layers, since as the thin film by the side of a substrate what has at least four kinds of crystallized states, such as a single crystal, an amorphous state, a polycrystal, and an orientated polycrystal can be formed, as the thin film which is formed on it what has at least four kinds of crystallized states, a single crystal, an amorphous state, a polycrystal, and an orientated polycrystal can be formed respectively, and as the thin film which is formed on it what has at least four kinds of crystallized states, a single crystal, an amorphous state, a polycrystal, and an orientated polycrystal can be formed furthermore respectively, three-layer thin film formation which consists of combinations of a total of at least 64 kinds in which crystallized states differ is possible.

As for the thin film of four or more layers, as mentioned above, if it is a four-layer thin film, they are at least 256 kinds, if it is a five-layer thin film, they are at least 1024 kinds, or if it is a six-layer thin film, they are at least 4096 kinds, if it is a seven-layer thin film, they are at least 16384 kinds, if it is an eight more layer thin film, they are at least combinations of 65536 kinds, etc., formation of all the multilayered films with which crystallized states differ by combining the crystallized state of each layer arbitrarily is possible.

In this invention, as for the thickness in each layer of a thin film which comprises as the main ingredients at least one or more materials selected from a gallium nitride, an indium nitride, and an aluminum nitride and is formed in two or more layers on the substrate which consists of a sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., arbitrary combination is also possible.

Usually, the thickness of each thin film layer is used, respectively, combining suitably a 0.5 nm-1000 μm range thing.

Thus, in this invention, as for the thin film which comprises as the main ingredients at least one or more materials selected from a gallium nitride, an indium nitride, and an aluminum nitride which is being formed on the thin film substrate in which the thin film which comprises as the main ingredients at least one or more materials selected from a gallium nitride, an indium nitride, and an aluminum nitride and which is formed on the sintered compact which comprises an aluminum nitride as the main ingredients, not only what is a single crystallized state but also what consists of a constitution which combined two or more different crystallized states which are either which is selected from a single crystal, an amorphous state, a polycrystal, and an orientated polycrystal at least suitably can be used.

As the combination of the crystallized state of such thin film, for example, when a thin film consists of two different crystallized states, since the thin film by the side of a substrate which consists of a sintered compact which comprises an aluminum nitride as the main ingredients can be formed as at least four kinds of crystallized states, such as a single crystal, an amorphous state, a polycrystal, and an orientated polycrystal, the thin film which is formed on it can be formed as at least four kinds of crystallized states, such as a single crystal, an amorphous state, a polycrystal, and an orientated polycrystal respectively, the combination of a total of 12 kinds can be formed in the thin film which consists of two different crystallized states.

And, for example, when a thin film consists of three different crystallized states respectively, since the thin film by the side of a substrate which consists of a sintered compact which comprises an aluminum nitride as the main ingredients can be formed as at least 4 kinds of crystallized states, such as a single crystal, an amorphous state, a polycrystal, and an orientated polycrystal, the thin film which is formed on it can be formed as at least 4 kinds of crystallized states, such as a single crystal, an amorphous state, a polycrystal, and an orientated polycrystal, the thin film which is formed furthermore on it can be formed as at least 4 kinds of crystallized states, such as a single crystal, an amorphous state, a polycrystal, and an orientated polycrystal respectively, the combination of a total of 36 kinds can be formed in the thin film which consists of three different crystallized states.

Moreover, when a thin film consists of four or more different crystallized states, the combination of a different crystallized state can be formed infinitely, as mentioned above, such as, if a thin film consists of four different crystallized states the combination of 108 kinds can be formed, if a thin film consists of five different crystallized states the combination of 324 kinds can be formed, if a thin film consists of 6 different crystallized states the combination of 972 kinds can be formed, if a thin film consists of 7 different crystallized states the combination of 2916 kinds can be formed, if a thin film consists of 8 different crystallized states the combination of 8748 kinds can be formed.

The single crystal thin film substrate according to this invention is what formed at least the single crystal thin film even if the thin film currently formed is multilayered, each layer consists of various crystallized states, such as a single crystal, an amorphous state, a polycrystal, and an orientated polycrystal, and composition also differs in each thin film layer and furthermore thickness also differs on each layer.

As for the crystallinity of a single crystal thin film currently formed in the above-mentioned single crystal thin film substrate, what is formed on it by using the substrate which formed beforehand the thin film of various crystallized states, such as a single crystal, an amorphous state, a polycrystal, and an orientated polycrystal is usually superior to what is directly formed on the substrate.

The thin film which is formed in the single crystal thin film substrate according to this invention contains at least a single crystal thin film even if the thin film is multilayered, each layer consists of various crystallized states, such as a single crystal, an amorphous state, a polycrystal, and an orientated polycrystal, and composition also differs in each thin film layer and furthermore thickness also differs on each layer.

That ingredients differ in the thin film which consists of at least two or more layers means that substantial composition of a thin film differs, as composition of a thin film, not only the thing whose rate of an ingredient which consists of at least one or more materials selected from a gallium nitride, an indium nitride, and an aluminum nitride and which is the main ingredients of this thin film differs but also the case where the main ingredients of the thin film is only one kind of a gallium nitride, an indium nitride, and an aluminum nitride and the other ingredient is only a doping agent substantially, etc., for example, are included.

Speaking more concretely, in the case of the thin film which consists of only a gallium nitride as the main ingredients and substantially only a magnesium (Mg) as a doping agent in addition to this, that from which the composition ratio of a gallium nitride and magnesium differs is also contained.

Or similarly, in the case of the thin film which consists of only an aluminum nitride as the main ingredients and substantially only a silicon (Si) as a doping agent in addition to this, that from which the composition ratio of an aluminum nitride and silicon differs is also contained.

In this invention, as mentioned above, on the substrate which consists of a sintered compact which comprises an aluminum nitride as the main ingredients, not only the thin film of the same ingredient which comprises as the main ingredients at least one or more materials selected from a gallium nitride, an indium nitride, and an aluminum nitride can be formed directly as single layer or in two or more layers, but also as a thin film of at least two or more layers which consists of a different ingredient.

Even if the thin film is what formed the same ingredient in two or more layers or what formed what has a different ingredient in two or more layers, when each formed thin film is a single crystal, the single crystal thin film which has the crystallinity, such that the half width of the rocking curve of the X-ray diffraction line from the lattice plane of a Miller Index (002) is not more than 240 seconds, can be obtained,

And, if the above mentioned thin film which consists of two or more layers will be formed by using the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., the thing excellent in crystallinity not more than 300 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride can be obtained, and it is preferred.

In this invention, as mentioned above, the thin film which was formed on the substrate which consists of a sintered compact which comprises an aluminum nitride as the main ingredients or on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., can form not only as single layer but also as the thin film which consists of at least two or more layers which contains a single crystal thin film.

In this invention, as the above-mentioned thin film which can be formed in the two or more layers which contains a single crystal thin film, not only the thin film that may be formed on the substrate for thin film formation which consists of a sintered compact which comprises an aluminum nitride as the main ingredients or various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., but also the thin film currently formed in the thin film substrate according to this invention are contained.

That is, in this invention, the above-mentioned thin film which can be formed in the two or more layers contains two thin films of the thin film that may be formed on the substratrfor thin film formation and the thin film which is formed in the thin film substrate.

It was shown clearly that these thin films can be formed not only as a single layer but also as a thin film which contains at least two or more layers of the single crystal thin film.

As mentioned above, this invention offers the substrate for thin film formation which consists of a sintered compact which comprises an aluminum nitride as the main ingredients and which can form the thin film which consists of at least one or more materials selected from a gallium nitride, an indium nitride, and an aluminum nitride and has at least one of the crystallized states selected from an amorphous state, a polycrystal, an orientated polycrystal, and a single crystal.

Moreover, the thin film substrate in which the thin film which consists of at least one or more materials selected from a gallium nitride, an indium nitride, and an aluminum nitride and has at least one of the crystallized states selected from an amorphous state, a polycrystal, an orientated polycrystal, and a single crystal is being formed on the substrate which consists of a sintered compact which comprises an aluminum nitride as the main ingredients is also provided.

Moreover, a substrate for thin film formation which consists of various sintered compacts which can form the thin film consisting of at least one or more materials selected from a gallium nitride, an indium nitride, and an aluminum nitride and having at least one of the crystallized states selected from an amorphous state, a polycrystal, an orientated polycrystal, and a single crystal and which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is provided.

Moreover, a thin film substrate in which the thin film which consists of at least one or more materials selected from a gallium nitride, an indium nitride, and an aluminum nitride and has at least one of the crystallized states selected from an amorphous state, a polycrystal, an orientated polycrystal, and a single crystal is being formed on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is also provided.

The above-mentioned substrate for thin film formation is mainly used, in order to form the thin films of various crystallized states, such as an amorphous state, a polycrystal, and an orientated polycrystal, including the single crystal which consists of at least one or more materials selected from a gallium nitride, an indium nitride, and an aluminum nitride.

And, the above-mentioned thin film substrate also can be mainly used in order to form the thin films of various crystallized states, such as an amorphous state, a polycrystal, and an orientated polycrystal, including the single crystal which consists of at least one or more materials selected from a gallium nitride, an indium nitride, and an aluminum nitride.

As mentioned above, this invention will offer two kinds of substrates, such as, (1) the substrate for thin film formation for forming the thin film which comprises as the main ingredients at least one or more materials selected from a gallium nitride, an indium nitride, and an aluminum nitride and which is various crystallized states including the single crystal, such as an amorphous state, a polycrystal, and an orientated polycrystal etc., (2) the thin film substrate in which the thin film which comprises as the main ingredients at least one or more materials selected from a gallium nitride, an indium nitride, and an aluminum nitride and which is at least various crystallized states including a single crystal, such an amorphous state, a polycrystal, and an orientated polycrystal etc., was formed.

The single crystal thin film which comprises as the main ingredients at least one or more materials selected from a gallium nitride, an indium nitride, and an aluminum nitride can be formed on the two above-mentioned kinds of substrates.

What has a conduction via, respectively is contained in these two kinds of substrates.

Saying more concretely about the above-mentioned two kinds of substrates, they are the following two kinds, such as, (1) the substrate for thin film formation for forming: what used as the substrate the sintered compact which comprises various ceramic materials including an aluminum nitride as the main ingredients as it was,

(2) the thin film substrate: what formed the thin film which comprises as the main ingredients at least one or more materials selected from a gallium nitride, an indium nitride, and an aluminum nitride and which has at least one of the crystallized states selected from an amorphous state, a polycrystal, and an orientated polycrystal including a single crystal, on the sintered compact which comprises various ceramic materials including an aluminum nitride as the main ingredients.

This invention offers these.

The single crystal thin film which comprises as the main ingredients at least one or more materials selected from a gallium nitride, an indium nitride, and an aluminum nitride, respectively can be formed on the two above-mentioned kinds of substrates.

What has a conduction via, respectively is contained in these two kinds of substrates.

The above-mentioned thin film substrate can be used also as a substrate for thin film formation.

It explained that this invention was what offers two kinds of substrates, the substrate for thin film formation, and a thin film substrate, as mentioned above.

Although it explained that in two kinds of these substrates, the substrate for thin film formation is what used various ceramic materials including the sintered compact which comprises an aluminum nitride as the main ingredients as a substrate as they are, this substrate for thin film formation can use not only what used as the substrate the sintered compact which comprises an aluminum nitride as the main ingredients and the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., as they were but also what used as the substrate the thing which formd the thin film which comprises as the main ingredients at least one or more materials selected from a gallium nitride, an indium nitride, and an aluminum nitride on this sintered compact which comprises an aluminum nitride as the main ingredients and on the various sintered compacts which comprise as the main ingredients a ceramic material, such as a silicon carbide, a silicon nitride, a zinc oxide, a beryllium oxide, and an aluminum oxide etc.

That is, the substrate for thin film formation according to this invention can use two kinds of substrates, such as what used as the substrate the sintered compact which comprises an aluminum nitride as the main ingredients and the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., as they were, and what used as the substrate the thing which formd the thin film which comprises as the main ingredients at least one or more materials selected from a gallium nitride, an indium nitride, and an aluminum nitride on the sintered compact which comprises an aluminum nitride as the main ingredients and on the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc. (that is, homogeneous as a thin film substrate).

As mentioned above, the thin film which comprises as the main ingredients at least one or more materials selected from a gallium nitride, an indium nitride, and an aluminum nitride can be formed on various ceramic materials including the sintered compact which comprises an aluminum nitride as the main ingredients.

As mentioned above, what has crystallized states, such as a single crystal and an amorphous state, a polycrystal, and an orientated polycrystal, can be used as a thin film which comprises as the main ingredients at least one or more materials selected from a gallium nitride, an indium nitride, and an aluminum nitride which is formed on the sintered compact which comprises an aluminum nitride as the main ingredients and on the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc.

As mentioned above, this thin film can use not only what consists of the single crystallized state selected from a single crystal, an amorphous state, a polycrystal, and an orientated polycrystal but also what consists of at least two or more crystallized states selected from these crystallized states simultaneously.

And, as mentioned above, this thin film can use suitably not only what consists of single layer but also what consisted of at least two or more layers.

And, as mentioned above, this thin film can be used suitably not only what consists of single composition but also what consists of two or more different composition.

And, as mentioned above, this thin film comprises at least two or more layers as mentioned above, and even if it consists of at least two or more different composition in each thin film layer, it can be used suitably.

And, as mentioned above, even if this thin film has conductivity, it can be used suitably.

As mentioned above, by using as the substrate what formed beforehand the thin film which comprises as the main ingredients at least one or more materials selected from a gallium nitride, an indium nitride, and an aluminum nitride and which is formed on the sintered compact which comprises an aluminum nitride as the main ingredients and on the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., the crystallinity of the single crystal thin film which comprises as the main ingredients at least one or more materials selected from a gallium nitride, an indium nitride, and an aluminum nitride and is formed on it becomes easier to improve if it is compared with the case where the sintered compact which comprises an aluminum nitride as the main ingredients and does not form this thin film is used as a substrate as it is.

What has a conduction via is contained in the substrate in which the thin film which comprises as the main ingredients at least one or more materials selected from a gallium nitride, an indium nitride, and an aluminum nitride was formed on various ceramic materials including the sintered compact which comprises an aluminum nitride as the main ingredients.

In this invention, as mentioned above, two kinds of substrates can be used as a substrate for thin film formation, namely, what used as a substrate ceramic materials, such as a sintered compact which comprises an aluminum nitride as the main ingredients, as they were, and what used as a substrate the sintered compact which comprises an aluminum nitride as the main ingredients and which formed the thin film which comprises as the main ingredients at least one or more materials selected from a gallium nitride, an indium nitride, and an aluminum nitride.

That is, a substrate for thin film formation according to this invention includes what used the sintered compact which comprises an aluminum nitride as the main ingredients and the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., as the substrate as they are, the substrate which consists of a sintered compact which forms currently the thin film which comprises as the main ingredients at least one or more materials selected from a gallium nitride, an indium nitride, and an aluminum nitride and which comprises an aluminum nitride as the main ingredients and, and the substrate which consists of various sintered compacts which form currently the thin film which comprises as the main ingredients at least one or more materials selected from a gallium nitride, an indium nitride, and an aluminum nitride and which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc.

This invention also contains the thin film substrate in which the thin film which comprises as the main ingredients at least one or more materials selected from a gallium nitride, an indium nitride, and an aluminum nitride was formed on the sintered compact which comprises an aluminum nitride as the main ingredients and on the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc.

As a crystallized state of the thin film currently formed in the thin film substrate according to this invention, it may be what is not only a single crystal but also other than a single crystal state, such as an amorphous state, a polycrystal, an orientated polycrystal, etc.

Saying more detail, it may be what has at least one or more crystallized states selected from a single crystal, an amorphous state, a polycrystal, and an orientated polycrystal as a crystallized state of the thin film currently formed on the above-mentioned thin film substrate according to this invention, for example, it may be the thin film of only the amorphous state which comprises as the main ingredients at least one or more materials selected from a gallium nitride, an indium nitride, and an aluminum nitride which do not necessarily contain a single crystal.

If such thin film substrate according to this invention is illustrated more concretely, for example, 1) The thin film substrate in which the single crystal thin film which comprises as the main ingredients at least one or more materials selected from a gallium nitride, an indium nitride, and an aluminum nitride was formed on the sintered compact which comprises an aluminum nitride as the main ingredients and on the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., moreover for example, 2) The thin film substrate in which the amorphous thin film which comprises as the main ingredients at least one or more materials selected from a gallium nitride, an indium nitride, and an aluminum nitride was formed on the sintered compact which comprises an aluminum nitride as the main ingredients and on the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., moreover for example, 3) The thin film substrate in which the polycrystalline thin film which comprises as the main ingredients at least one or more materials selected from a gallium nitride, an indium nitride, and an aluminum nitride was formed on the sintered compact which comprises an aluminum nitride as the main ingredients and on the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., moreover for example, 4) The thin film substrate in which the orientated polycrystalline thin film which comprises as the main ingredients at least one or more materials selected from a gallium nitride, an indium nitride, and an aluminum nitride was formed on the sintered compact which comprises an aluminum nitride as the main ingredients and on the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., moreover for example, 5) The thin film substrate in which the amorphous thin film which comprises as the main ingredients at least one or more materials selected from a gallium nitride, an indium nitride, and an aluminum nitride was formed on the sintered compact which comprises an aluminum nitride as the main ingredients and on the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then the single crystal thin film which comprises as the main ingredients at least one or more materials selected from a gallium nitride, an indium nitride, and an aluminum nitride was formed furthermore on it, moreover for example, 6) The thin film substrate in which the polycrystalline thin film which comprises as the main ingredients at least one or more materials selected from a gallium nitride, an indium nitride, and an aluminum nitride was formed on the sintered compact which comprises an aluminum nitride as the main ingredients and on the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then the single crystal thin film which comprises as the main ingredients at least one or more materials selected from a gallium nitride, an indium nitride, and an aluminum nitride was formed furthermore on it, moreover for example, 7) The thin film substrate in which the orientated polycrystalline thin film which comprises as the main ingredients at least one or more materials selected from a gallium nitride, an indium nitride, and an aluminum nitride was formed on the sintered compact which comprises an aluminum nitride as the main ingredients and on the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then the single crystal thin film which comprises as the main ingredients at least one or more materials selected from a gallium nitride, an indium nitride, and an aluminum nitride was formed furthermore on it, moreover for example, 8) The thin film substrate in which the single crystal thin film which comprises as the main ingredients at least one or more materials selected from a gallium nitride, an indium nitride, and an aluminum nitride was formed on the sintered compact which comprises an aluminum nitride as the main ingredients and on the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then the single crystal thin film which comprises as the main ingredients at least one or more materials selected from a gallium nitride, an indium nitride, and an aluminum nitride was formed furthermore on it, moreover for example, 9) The thin film substrate in which the amorphous thin film which comprises as the main ingredients at least one or more materials selected from a gallium nitride, an indium nitride, and an aluminum nitride was formed on the sintered compact which comprises an aluminum nitride as the main ingredients and on the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., then the orientated polycrystalline thin film which comprises as the main ingredients at least one or more materials selected from a gallium nitride, an indium nitride, and an aluminum nitride was formed furthermore on it, then the single crystal thin film which comprises as the main ingredients at least one or more materials selected from a gallium nitride, an indium nitride, and an aluminum nitride was formed furthermore on it, etc.

In the thin film substrate according to this invention in which the thin film which comprises as the main ingredients at least one or more materials selected from a gallium nitride, an indium nitride, and an aluminum nitride was formed on the substrate which consists of a sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., a single crystal thin film can form on it, even if the thin film currently formed is multilayered and each layer is at least one or more crystallized states selected from a single crystal, an amorphous state, a polycrystal, and an orientated polycrystal, composition is also a difference in each thin film layer, and thickness furthermore also differs on each class.

As for the crystallinity of the single crystal thin film formed on the thin film substrate according to this invention, what was formed on it by using the substrate in which the thin film which is at least one or more crystallized states selected from a single crystal, an amorphous state, a polycrystal, and an orientated polycrystal was formed beforehand on the substrate which consists of a sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is superior to what is directly formed on the substrate which consists of a sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc.

In the above-mentioned thin film substrate according to this invention in which the thin film which comprises as the main ingredients at least one or more materials selected from a gallium nitride, an indium nitride, and an aluminum nitride was formed on the substrate which consists of a sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., that ingredients differ in the thin film which consists of at least two or more layers means that substantial composition of a thin film differs, as composition of a thin film, not only what has the difference of the rate of an ingredient which is the main ingredients of this thin film and consists of at least one or more materials selected from a gallium nitride, an indium nitride, and an aluminum nitride but also the case in which the main ingredients of the thin film consists of only one kind among a gallium nitride, an indium nitride, and an aluminum nitride and other ingredients are only a doping agent substantially, etc., for example, are contained.

Speaking more concretely, for example, in the case of what is only a gallium nitride as the main ingredients of a single crystal thin film and contained substantially only a magnesium (Mg) as a doping agent in addition to this, that from which the composition ratio of a gallium nitride and magnesium differs is also contained.

Or similarly, for example, in the case of what is only an aluminum nitride as the main ingredients of a single crystal thin film and contained substantially only a silicon (Si) as a doping agent in addition to this, that from which the composition ratio of an aluminum nitride and silicon differs is also contained.

In this invention, as mentioned above, on the substrate which consists of a sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., not only the thin film of the same ingredient which comprises as the main ingredients at least one or more materials selected from a gallium nitride, an indium nitride, and an aluminum nitride can be formed as single layer or in two or more layers, but also as a thin film of at least two or more layers which consists of a different ingredient.

Even if the thin film is what formed the same ingredient in two or more layers or what formed what has a different ingredient in two or more layers, if each formed thin film is a single crystal, the single crystal thin film which has the excellent crystallinity, such that the half width of the rocking curve of the X-ray diffraction line from the lattice plane of a Miller Index (002) is not more than 240 seconds, can be obtained.

Moreover, in this invention, in the substrate which consists of a sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., a thin film which comprises two or more layers can be formed, and what consists of at least two or more different composition in each thin film layer can be used suitably.

If this is explained more concretely, for example, if a thin film comprises three layers the thin film of two kinds of conditions is contained, such as, what consists of three layers in which the composition of two layers are same and one layer is different, what consists of three layers in which all the composition is different respectively.

Moreover, for example, if a thin film comprises four layers the thin film of three kinds of conditions is contained, such as, what consists of four layers in which the composition of two layers are same and two layers are different respectively, what consists of four layers in which the composition of three layers are same and one layer is different, what consists of four layers in which all the composition is different respectively.

As mentioned above, this invention offers the substrate for thin film formation which consists of a sintered compact which comprises an aluminum nitride as the main ingredients and which can form the thin film which consists of at least one or more materials selected from a gallium nitride, an indium nitride, and an aluminum nitride and has at least one or more crystallized states selected from an amorphous state, a polycrystal, an orientated polycrystal, and a single crystal.

Moreover, the thin film substrate in which the thin film which consists of at least one or more materials selected from a gallium nitride, an indium nitride, and an aluminum nitride and has at least one or more crystallized states selected from an amorphous state, a polycrystal, an orientated polycrystal, and a single crystal is being formed on the substrate which consists of a sintered compact which comprises an aluminum nitride as the main ingredients is also provided.

And, as mentioned above, this invention offers the substrate for thin film formation which consists of various sintered compacts which can form the thin film which consists of at least one or more materials selected from a gallium nitride, an indium nitride, and an aluminum nitride and has at least one or more crystallized states selected from an amorphous state, a polycrystal, an orientated polycrystal, and a single crystal and which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc.

Moreover, a thin film substrate in which the thin film which consists of at least one or more materials selected from a gallium nitride, an indium nitride, and an aluminum nitride and has at least one or more crystallized states selected from an amorphous state, a polycrystal, an orientated polycrystal, and a single crystal is being formed on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is also provided.

The above-mentioned substrate for thin film formation can be used in order to form a single crystal thin film among the thin films which consist of at least one or more materials selected from a gallium nitride, an indium nitride, and an aluminum nitride.

It can use, in order that the above-mentioned thin film substrate may also form the single crystal thin film which consists of at least one or more materials selected from a gallium nitride, an indium nitride, and an aluminum nitride.

Namely, a thin film substrate according to this invention is the thin film substrate, wherein the thin film which comprises as the main ingredients at least one or more materials selected from a gallium nitride, an indium nitride, and an aluminum nitride is being formed on the substrate which consists of a sintered compact which comprises an aluminum nitride as the main ingredients.

Moreover, a thin film substrate according to this invention is the thin film substrate, wherein the thin film which comprises as the main ingredients at least one or more materials selected from a gallium nitride, an indium nitride, and an aluminum nitride is being formed on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc.

Speaking more concretely, a thin film substrate according to this invention is the thin film substrate, wherein the thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal is being formed on the substrate which consists of a sintered compact which comprises an aluminum nitride as the main ingredients and substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc.

It was found out that the thin film which comprises as the main ingredients at least one or more materials selected from a gallium nitride, an indium nitride, and an aluminum nitride and which is formed on the substrate which consists of a sintered compact which comprises an aluminum nitride as the main ingredients and on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., can form what has conductivity.

Moreover, also when using as a substrate the thin film substrate which formed beforehand the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc. on this substrate by using a sintered compact which comprises an aluminum nitride as the main ingredients and various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., it was found out that the thin film which comprises as the main ingredients at least one or more materials selected from a gallium nitride, an indium nitride, and an aluminum nitride and which is formed on this substrate can form what has conductivity.

The thin film substrate which formed such conductive thin film which comprises as the main ingredients at least one or more materials selected from a gallium nitride, an indium nitride, and an aluminum nitride on the sintered compact which forms currently the conduction via and comprises an aluminum nitride as the main ingredients can connect electrically the up-and-down surface of this thin film substrate via this conduction via.

Therefore, if semiconductor devices, such as a light emitting device, are produced using the thin film substrate or the substrate for thin film formation in which such conductive thin film is being formed, since the electrode can arrange not only to one side but also to the up-and-down side of a device so thin film etching for taking out an electrode becomes unnecessary, and moreover, since the mounting characteristics of this device to the package can be raised, it is desirable.

In order to generate conductivity, it becomes to be able to semiconductor-ize into P type or N type by usually adding a doping agent to this thin film.

This thin film can be also used as one semiconductor layer which constitutes the light emitting device of multilayer structure by making it semiconductor-ize into P type or N type.

In this invention, the thin film which is various crystallized states, such as an amorphous state, a polycrystal, an orientated polycrystal, and a single crystal and is formed on the thin film substrate in which the thin film which comprises as the main ingredients at least one or more materials selected from a gallium nitride, an indium nitride, and an aluminum nitride and has the various crystallized states was formed on the substrate which consists of sintered compacts which comprise an aluminum nitride and various ceramic materials as the main ingredients can also form what has conductivity.

Although it becomes to generate conductivity also in the thin film of the various crystallized states formed in the above-mentioned thin film substrate in many cases by adding a doping agent and by making it semiconductor-ize into P type or N type, the thin film which comprises as the main ingredients a gallium nitride and an indium nitride (including the thin film which consists of mixed composition of gallium nitride+indium nitride) in the thin film which comprises as the main ingredients at least one or more materials selected from a gallium nitride, an indium nitride, and an aluminum nitride may be semiconductor-ized spontaneously into N type without doping agent, electrical conductivity may be generated.

The thin film of various crystallized states which is formed on the thin film substrate according to this invention can be used as one semiconductor layer which constitutes the light emitting device of multilayer structure by making it semiconductor-ize into P type or N type.

By making the above-mentioned thin film of the above-mentioned various crystallized states semiconductor-ize, if semiconductor devices, such as a light emitting device formed on the substrate which consists of a sintered compact which comprises an aluminum nitride as the main ingredients and which has a conduction via, are produced, since the electrode can arrange not only to one side but also to the up-and-down side of a device, thin film etching for taking out an electrode becomes unnecessary, and moreover, since the mounting characteristics of this device to the package can be raised, it is desirable.

As the doping agent for making a thin film of the various crystallized states according to this invention into P type semiconductor, it can use one or can use two or more simultaneously, from magnesium, beryllium, zinc, and carbon, etc.

As the doping agent for making a thin film of the various crystallized states according to this invention into N type semiconductor, it can use one or can use two or more simultaneously, from silicon and oxygen, etc.

Semiconductor-izing is also possible by so-called co-doping using both the above-mentioned doping agent for N-type semiconductor formation and for P type semiconductor formation.

As for the specific resistance of the above-mentioned semiconductor-ized thin film of various crystallized states, such as an amorphous state, a polycrystal, an orientated polycrystal, and a single crystal, it is preferred that it is not more than 1×10⁴ Ω·cm in room temperature.

It is more preferred that it is not more than 1×10² Ω·cm as specific resistance in room temperature.

It is still more preferred that it is not more than 1×10¹ Ω·cm as specific resistance in room temperature.

It is most preferred that it is not more than 1×10⁰ Ω·cm as specific resistance in room temperature.

The thin film which have such specific resistance and comprises as the main ingredients at least one or more materials selected from a gallium nitride, an indium nitride, and an aluminum nitride can be formed on the substrate which consists of a sintered compact which comprises an aluminum nitride as the main ingredients, on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., and on the thin film substrate in which the thin film which comprises as the main ingredients at least one or more materials selected from a gallium nitride, an indium nitride, and an aluminum nitride is being formed beforehand on these substrates.

The conductive thin film which is various crystallized states, such as a single crystal, an amorphous state, a polycrystal, and an orientated polycrystal, and which comprises as the main ingredients at least one or more materials selected from a gallium nitride, an indium nitride, and an aluminum nitride can be formed on the substrate which consists of a sintered compact which comprises an aluminum nitride as the main ingredients, on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., and on the thin film substrate in which the thin film which comprises as the main ingredients at least one or more materials selected from a gallium nitride, an indium nitride, and an aluminum nitride is being formed beforehand on these substrates according to this invention as mentioned above.

As for the doping agent for making the above-mentioned thin film of various crystallized states according to this invention which comprises as the main ingredients at least one or more materials selected from a gallium nitride, an indium nitride, and an aluminum nitride and which is formed on the substrate which consists of a sintered compact which comprises an aluminum nitride as the main ingredients, the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., and the thin film substrate into P type semiconductor, it can use one or can use two or more simultaneously, from magnesium (Mg), beryllium (Be), calcium (Ca), zinc (Zn), cadmium (Cd), and carbon (C), etc.

And, as the doping agent for making this thin film of various crystallized states which comprises as the main ingredients at least one or more materials selected from a gallium nitride, an indium nitride, and an aluminum nitride into N type semiconductor, it can use one or can use two or more simultaneously, from silicon (Si), germanium (Ge), oxygen (O), selenium (Se), and tellurium (Te), etc.

Semiconductor-izing is also possible by so-called co-doping using both the above-mentioned doping agent for N-type semiconductor formation and P type semiconductor formation.

The semiconductor-ized thin film which has specific resistance of not more than 1×10⁴ Ω·cm in room temperature and which comprises as the main ingredients at least one or more materials selected from a gallium nitride, an indium nitride, and an aluminum nitride and has various crystallized states, such as an amorphous state, a polycrystal, an orientated polycrystal, and a single crystal, etc. can be formed on the above-mentioned substrate for thin film formation and the thin film substrate.

Since the thin film which has specific resistance of not more than 1×10² Ω·cm in room temperature and has various crystallized states, such as an amorphous state, a polycrystal, an orientated polycrystal, and a single crystal can be formed on the above-mentioned substrate for thin film formation and the thin film substrate, it is desirable.

Furthermore, since the thin film which has specific resistance of not more than 1×10¹ Ω·cm in room temperature and has various crystallized states, such as an amorphous state, a polycrystal, an orientated polycrystal, and a single crystal can be formed on the above-mentioned substrate for thin film formation and the thin film substrate, it is more desirable.

Moreover, since the thin film which has specific resistance of not more than 1×10₀ Ω·cm in room temperature and has various crystallized states, such as an amorphous state, a polycrystal, an orientated polycrystal, and a single crystal can be formed on the above-mentioned substrate for thin film formation and the thin film substrate, it is still more desirable.

If the thin film of various crystallized states according to this invention, such as an amorphous state, a polycrystal, an orientated polycrystal, and a single crystal, is semiconductor-ized in such above specific resistance, the thin film of these various crystallized states can be used directly as a part of light emitting device, the production process which etches a part of thin film layer which forms the light emitting device for forming the electrode of a light emitting device can be skipped, and furthermore it is advantageous when it mounts this light emitting device on a package.

Since conductivity of the thin film containing doping agents, such as Mg, Be, Ca, Zn, Cd, C, Si, Ge, O, Se, and Te, etc. may improve, usually, by reheating processing may be performed in the ambient atmosphere after this thin film formation, in pure N₂ and in a vacuum, etc. or by irradiating an electron ray, etc., performing suitably is preferred.

As for the content of the doping ingredient, such as Mg, Be, Ca, Zn, Cd, and C, etc. used in order to semiconductor-ize the thin film which comprises as the main ingredients at least one or more materials selected from a gallium nitride, an indium nitride, and an aluminum nitride into P type, and the content of the doping ingredient, such as Si, Ge, O, Se, Te, etc. used in order to semiconductor-ize the thin film which comprises as the main ingredients at least one or more materials selected from a gallium nitride, an indium nitride, and an aluminum nitride into N type, it is preferred that it is usually the range of 0.00001-10 mol % to the main ingredients which consist of at least one or more materials selected from a gallium nitride, an indium nitride, and an aluminum nitride, specific resistance in the room temperature of this thin film which comprises as the main ingredients at least one or more materials selected from a gallium nitride, an indium nitride, and an aluminum nitride can be made into at least not more than 1×10⁴ Ω·cm.

In the thin film which contains the above-mentioned doping ingredient in the range of 0.00001-10 mol % and which comprises as the main ingredients at least one or more materials selected from a gallium nitride, an indium nitride, and an aluminum nitride, in the case of the thin film which has the composition whose main ingredients contain an aluminum nitride ingredient not more than 95 mol % and is that whose remainder is at least one or more materials selected from a gallium nitride and an indium nitride, usually, the specific resistance in room temperature can produce what has at least not more than 1×10² Ω·cm.

And, in the thin film which contains the above-mentioned doping ingredient in the range of 0.00001-10 mol % and which comprises as the main ingredients at least one dor more materials selected from a gallium nitride, an indium nitride, and an aluminum nitride, in the case of the thin film which has the composition whose main ingredients contain an aluminum nitride ingredient not more than 55 mol % and is that whose remainder is at least one or more materials selected from a gallium nitride and an indium nitride, usually, the specific resistance in room temperature can produce what has at least not more than 1×10¹ Ω·cm.

As mentioned above, in this invention, in the substrate for thin film formation and the thin film substrate using the sintered compact which comprises an aluminum nitride as the main ingredients and the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., as a substrate, a thin film which has conductivity and which comprises as the main ingredients at least one or more materials selected from a gallium nitride, an indium nitride, and an aluminum nitride and has various crystallized states, such as an amorphous state, a polycrystal, an orientated polycrystal, and a single crystal etc., can be formed.

In this invention, in such thin film, the conductive thin film which comprises as the main ingredients two ingredients of a gallium nitride and an aluminum nitride expressed with the chemical composition type of AlₓGa₁₋ₓN (0≦x≦1.0) and has various crystallized states, such as an amorphous a polycrystal, an orientated polycrystal, and a single crystal, can also be obtained.

Since the thin film of the above-mentioned two-ingredient system has little absorption of ultraviolet light with a wavelength not more than 380 nm, if the thin film substrate in which this material was formed is used as a substrate for light emitting device production, there is little optical absorption by a substrate, so the light emitting device of good luminous efficiency can manufacture.

The conductivity of this two-ingredient system thin film is acquired by semiconductor-izing into P type and N type using a doping agent.

It is preferred to use magnesium (Mg) for P type semiconductor-izing as doping agent and to use silicon (Si) for N type semiconductor-izing as doping agent.

The thin film of the above-mentioned two-ingredient system can contain Mg in the range of 0.00001-10 mol % to the composite expressed with the chemical formula of main-ingredient AlₓGa₁₋ₓN (0≦x≦1.0), and can form the conductive thin film which has specific resistance of not more than 1×10⁴ Ω·cm in room temperature and has various crystallized states, such as an amorphous state, a polycrystal, an orientated polycrystal, and a single crystal.

Among them, the thin film which contains Mg in the range of 0.00001-10 mol % to the composite expressed with the chemical formula of main-ingredient AlₓGa₁₋ₓN (0≦x≦0.6) can form the conductive thin film which has specific resistance of about 1×10⁻¹ Ω·cm-1×10² Ω·cm in room temperature and has various crystallized states, such as an amorphous state, a polycrystal, an orientated polycrystal, and a single crystal.

In the thin film of the above-mentioned two-ingredient system, the thin film with contains Mg in the range of 0.00001-0.5 mol % to the composite expressed with the chemical formula of main-ingredient AlₓGa₁₋ₓN (0.6≦x≦1.0) can form the conductive thin film which has specific resistance of not more than 1×10⁴ Ω·cm in room temperature and has various crystallized states, such as an amorphous state, a polycrystal, an orientated polycrystal, and a single crystal.

The thin film of the above-mentioned two-ingredient system can contain Si in the range of 0.00001-10 mol % to the composite expressed with the chemical formula of main-ingredient AlₓGa₁₋ₓN (0≦x≦1.0), and can form the conductive thin film which has specific resistance of not more than 1×10² Ω·cm-1×10⁴ Ω·cm in room temperature and has various crystallized states, such as an amorphous state, a polycrystal, an orientated polycrystal, and a single crystal.

Among them, the thin film which contains Si in the range of 0.00001-0.5 mol % to the composite expressed with the chemical formula of main-ingredient AlₓGa₁₋ₓN (0.6≦x≦1.0) can form the conductive thin film which has specific resistance of not more than 1×10² Ω·cm-1×10³ Ω·cm in room temperature and has various crystallized states, such as an amorphous state, a polycrystal, an orientated polycrystal, and a single crystal.

The thin film of this composition contains the thin film which consists of what is x=1.0, i.e., only an aluminum nitride as the main ingredients, and contains Si in the range of 0.00001 mol %-0.5 mol %.

The thin film which contains Si in the range of 0.00001-10 mol % to the composite expressed with the chemical formula of main-ingredient AlₓGa₁₋ₓN (0≦x≦0.6) can form the conductive thin film which has comparatively low resistance of about 1×10⁻³ Ω·cm-1×10¹ Ω·cm in room temperature as specific resistance and has various crystallized states, such as an amorphous state, a polycrystal, an orientated polycrystal, and a single crystal.

In the above-mentioned two-ingredient system thin film, Mg and Si can be contained simultaneously in the range of 0.00001-10 mol % in total to the composite expressed with the chemical formula of main-ingredient AlₓGa₁₋ₓN (0≦x≦1.0), and the conductive thin film which has specific resistance of not more than 1×10⁴ Ω·cm in room temperature and has various crystallized states, such as an amorphous state, a polycrystal, an orientated polycrystal, and a single crystal, can be formed.

In addition, for example, that the content of a doping agent, such as Mg and Si, etc., is 0.00001-10 mol % to the main ingredients means that the above-mentioned two-ingredient system thin film consists of the composition which contains AlₓGa₁₋ₓN of a main ingredient in the range of 90-99.99999 mol % and contains the doping agent, such as Mg and Si etc., in the range of 0.00001-10 mol %.

In this invention, the sintered compact which comprises an aluminum nitride as the main ingredients or the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., can be used as a substrate for forming the thin film which comprises as the main ingredients at least one or more materials selected from a gallium nitride, an indium nitride, and an aluminum nitride and has various crystallized states, such as a single crystal thin film, an amorphous state, a polycrystal, and an orientated polycrystal etc.

And in this invention, the thin film substrate in which the thin film which comprises as the main ingredients at least one or more materials selected from a gallium nitride, an indium nitride, and an aluminum nitride and has various crystallized states, such as a single crystal thin film, an amorphous state, a polycrystal, and an orientated polycrystal etc., is formed on the substrate which consists of a sintered compact which comprises an aluminum nitride as the main ingredients or on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., can be provided.

Although what is arbitrary can form as the thickness of this thin film, when forming this thin film on the substrate for thin film formation which consists of the above-mentioned various sintered compacts which comprise a ceramic material as the main ingredients, in order to make a pinhole and a defect, etc. in a thin film easy to reduction-ize, it is desirable that the thickness is at least not less than 0.5 nm.

The thin film directly formed on the above-mentioned substrate for thin film formation which consists of a sintered compact which comprises an aluminum nitride as the main ingredients can also form the thickness not less than 0.5 nm, or what has not less than 10 μm.

Moreover, what has not less than 50 μm can also be formed.

In this invention, as mentioned above, using methods suitably, such as a MOCVD (Metal Organic Chemical Vapor Deposition) method, an MOVPE (Metal Organic Vapor Phase Epitaxy) method, a Hydride VPE (Hydride Vapor Phase Epitaxy) method, a Chloride VPE (Chloride Vapor Phase Epitaxy) method, a Plasma CVD method, other CVD (Chemical Vapor Deposition) methods, or an MBE (Molecular Beam Epitaxy) method, or a laser ablation method using excimer laser, a PLD (pulsed-laser deposition: pulsed laser decomposition) method, etc., or a Sputtering method, etc., even if it is a thin film with comparatively thick thickness of about 500 μm-1000 μm, it can form comparatively easily.

Especially, while the growth rate of a thin film is 5 μm-10 μm per hour at the maximum and it is usually less than it and is comparatively small in many cases by the MOCVD method or the MOPVE method, if a Chloride VPE method, and a Halide VPE method, etc. which use halogenated compounds as a raw material, such as a gallium chloride are used, since the growth rate of a thin film is large as 5 μm-200 μm per hour and a thin film with thick thickness can form in a shorter time, it is desirable.

As for the thin film which comprises as the main ingredients at least one or more materials selected from a gallium nitride, an indium nitride, and an aluminum nitride and which is various crystallized states, such as a single crystal thin film, an amorphous state, a polycrystal, and an orientated polycrystal etc., what has the same thickness as the above is obtained comparatively easily not only in what was directly formed on the above-mentioned substrate for thin film formation which consists of a sintered compact which comprises an aluminum nitride as the main ingredients but also in what is formed on the thin film substrate which is produced using the sintered compact comprising an aluminum nitride as the main ingredients and which formed the thin film comprising at least one or more materials selected from a gallium nitride, an indium nitride, and an aluminum nitride as the main ingredients and having various crystallized states, such as a single crystal, an amorphous state, a polycrystal, and an orientated polycrystal etc.

In this invention, although the crystallinity of the single crystal thin film and the orientated polycrystalline thin film which comprise as the main ingredients at least one or more materials selected from a gallium nitride, an indium nitride, and an aluminum nitride and which are formed on the substrate which consists of a sintered compact which comprises an aluminum nitride as the main ingredients is influenced by the composition and optical permeability of a sintered compact, or the size of a sintered compact particle, the surface state of a substrate, the constitution of the thin film layer formed, or thin film formation conditions, as mentioned above, on the other hand, it is influenced by the thickness of this thin film formed.

In this invention, in the substrate which consists of a sintered compact which comprises an aluminum nitride as the main ingredients, a single crystal thin film with the thickness not less than 0.5 nm which comprises as the main ingredients at least one or more materials selected from a gallium nitride, an indium nitride, and an aluminum nitride can be formed.

As the crystallinity of the single crystal thin film of this thickness what is not more than 300 seconds as half width of the rocking curve of the X-ray diffraction line from the lattice plane of a Miller Index (002) can form.

The above-mentioned single crystal thin film with the thickness not less than 0.3 μm can also be formed by using the substrate for thin film formation or the thin film substrate which consists of a sintered compact which comprises an aluminum nitride as the main ingredients according to this invention.

If the thickness of the single crystal thin film which comprises as the main ingredients at least one or more materials selected from a gallium nitride, an indium nitride, and an aluminum nitride is what is not less than 0.3 μm, the single crystal thin film which has the crystallinity, such that the half width of the rocking curve of the X-ray diffraction line from the lattice plane of a Miller Index (002) is not more than 240 seconds, is easy to be obtained.

The above-mentioned single crystal thin film with the thickness not less than 3.5 μm can also be formed by using the substrate according to this inventiont which consists of a sintered compact which comprises an aluminum nitride as the main ingredients.

If the thickness of the single crystal thin film which comprises as the main ingredients at least one or more materials selected from a gallium nitride, an indium nitride, and an aluminum nitride is what is not less than 3.5 μm, the single crystal thin film which has the crystallinity, such that the half width of the rocking curve of the X-ray diffraction line from the lattice plane of a Miller Index (002) is not more than 200 seconds, is easy to be obtained.

A comparatively thick single crystal thin film not less than 10 μm can also be formed using the substrate which consists of a sintered compact according to this invention which comprises an aluminum nitride as the main ingredients.

Even if the thickness of a single crystal thin film which comprises as the main ingredients at least one or more materials selected from a gallium nitride, an indium nitride, and an aluminum nitride is what is not less than 10 μm, the single crystal thin film which is excellent in crystallinity, such that the half width of the rocking curve of the X-ray diffraction line from the lattice plane of a Miller Index (002) is not more than 150 seconds, is easy to be obtained.

Not less than 50 μm is possible enough as thickness of a single crystal thin film which comprises as the main ingredients at least one or more materials selected from a gallium nitride, an indium nitride, and an aluminum nitride and is formed on the substrate according to this invention which consists of a sintered compact which comprises an aluminum nitride as the main ingredients.

In the substrate according to this invention which consists of a sintered compact which comprises an aluminum nitride as the main ingredients, the single crystal thin film which has the crystallinity, such that the half width of the rocking curve of the X-ray diffraction line from the lattice plane of a Miller Index (002) is not more than 130 seconds, is easy to be obtained, if it is not less than 50 μm as thickness of a single crystal thin film which comprises as the main ingredients at least one or more materials selected from a gallium nitride, an indium nitride, and an aluminum nitride, it is preferred.

In the substrate according to this invention which consists of a sintered compact which comprises an aluminum nitride as the main ingredients, about 500 μm is possible enough as thickness of a single crystal thin film which comprises as the main ingredients at least one or more materials selected from a gallium nitride, an indium nitride, and an aluminum nitride, and a single crystal thin film with a thickness of 1000 μm is actually obtained.

Even if the thickness of the single crystal thin film which comprises as the main ingredients at least one or more materials selected from a gallium nitride, an indium nitride, and an aluminum nitride is about 500 μm-1000 μm, the single crystal thin film which has the crystallinity, such that the half width of the rocking curve of the X-ray diffraction line from the lattice plane of a Miller Index (002) is not more than 300 seconds, can be obtained, if the substrate in which this single crystal thin film is formed directly is the sintered compact which comprises an aluminum nitride as the main ingredients, the thing excellent in crystallinity not more than 130 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride is obtained.

In this invention, as for the above shown relation between the thickness and crystallinity of the single crystal thin film which comprises as the main ingredients at least one or more materials selected from a gallium nitride, an indium nitride, and an aluminum nitride, not only in what was directly formed on the sintered compact which comprises an aluminum nitride as the main ingredients, but also in the single crystal thin film formed on the thin film substrate which is produced by using the sintered compact which comprises an aluminum nitride as the main ingredients and which formed beforehand the thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal etc., it has the same relation between the thickness and crystallinity of the thin film.

And as a substrate, not only on what consists of the above-mentioned sintered compact which comprises an aluminum nitride as the main ingredients but also on the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., the thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal, can be formed.

In this invention, although the crystallinity of the single crystal thin film and the orientated polycrystalline thin film which comprise as the main ingredients at least one or more materials selected from a gallium nitride, an indium nitride, and an aluminum nitride and which are formed on the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., is influenced by the surface state of a substrate, the constitution of the thin film layer formed, or thin film formation conditions, as mentioned above, on the other hand, it is influenced by the thickness of this thin film formed.

In this invention, in the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., a single crystal thin film with the thickness not less than 0.5 nm which comprises as the main ingredients at least one or more materials selected from a gallium nitride, an indium nitride, and an aluminum nitride can be formed.

As for the crystallinity, what is not more than 300 seconds can form as half width of the rocking curve of the X-ray diffraction line from the lattice plane of the Miller Index (002) of this single crystal thin film.

The above-mentioned single crystal thin film with the thickness not less than 0.3 μm can also be formed using the substrate which consists of various sintered compacts according to this invention which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

Also in that whose thickness of the single crystal thin film which comprises as the main ingredients at least one or more materials selected from a gallium nitride, an indium nitride, and an aluminum nitride is not less than 0.3 μm, the single crystal thin film which has the crystallinity, such that the half width of the rocking curve of the X-ray diffraction line from the lattice plane of a Miller Index (002) is not more than 300 seconds, is easy to be obtained.

The above-mentioned single crystal thin film with the thickness not less than 3.5 μm can also be formed using the substrate which consists of various sintered compacts according to this invention which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

If the thickness of the single crystal thin film which comprises as the main ingredients at least one or more materials selected from a gallium nitride, an indium nitride, and an aluminum nitride is what is not less than 3.5 μm, the single crystal thin film which has the crystallinity, such that the half width of the rocking curve of the X-ray diffraction line from the lattice plane of a Miller Index (002) is not more than 240 seconds, is easy to be obtained.

A comparatively thick single crystal thin film of not less than 10 μm can also be formed using the substrate which consists of various sintered compacts according to this invention which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

Even if the thickness of the single crystal thin film which comprises as the main ingredients at least one or more materials selected from a gallium nitride, an indium nitride, and an aluminum nitride is not less than 10 μm, the single crystal thin film which is excellent in crystallinity, such that the half width of the rocking curve of the X-ray diffraction line from the lattice plane of a Miller Index (002) is not more than 240 seconds, is easy to be obtained.

Moreover, not less than 50 μm are possible enough as thickness of the single crystal thin film which comprises as the main ingredients at least one or more materials selected from a gallium nitride, an indium nitride, and an aluminum nitride and is formed on the substrate which consists of various sintered compacts according to this invention which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

On the substrate according to this invention which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., the single crystal thin film which has the crystallinity, such that the half width of the rocking curve of the X-ray diffraction line from the lattice plane of a Miller Index (002) is not more than 200 seconds, is easy to be obtained, if the thickness of the single crystal thin film which comprises as the main ingredients at least one or more materials selected from a gallium nitride, an indium nitride, and an aluminum nitride is what is not less than 50 μm, it is preferred.

What is 500 μm-1000 μm is possible enough as the thickness of a single crystal thin film which comprises as the main ingredients at least one or more materials selected from a gallium nitride, an indium nitride, and an aluminum nitride and is formed on the substrate according to this invention which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

In the substrate according to this invention which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., the single crystal thin film which has the crystallinity, such that the half width of the rocking curve of the X-ray diffraction line from the lattice plane of a Miller Index (002) is not more than 200 seconds, is easy to be obtained, even if the thickness of the single crystal thin film which comprises as the main ingredients at least one or more materials selected from a gallium nitride, an indium nitride, and an aluminum nitride is 500 μm-1000 μm.

In this invention, as for the above shown relation between the thickness and crystallinity of the single crystal thin film which comprises as the main ingredients at least one or more materials selected from a gallium nitride, an indium nitride, and an aluminum nitride, not only in what formed as single layer on the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., but also in the single crystal thin film formed on the thin film substrate which formed beforehand the thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal, and is produced by using the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., it has the same relation between the thickness and crystallinity of the thin film.

As mentioned above, in this invention, even if the single crystal thin film which comprises as the main ingredients at least one or more materials selected from a gallium nitride, an indium nitride, and an aluminum nitride and is formed on the substrate which consists of a sintered compact which comprises an aluminum nitride as the main ingredients is thinner if it is compared with the thickness of this single crystal thin film formed in the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., what is excellent crystallinity is easy to be obtained.

As mentioned above, in this invention, the thin film which comprises as the main ingredients at least one or more materials selected from a gallium nitride, an indium nitride, and an aluminum nitride and is formed on the substrate which consists of a sintered compact which comprises an aluminum nitride as the main ingredients or on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., can form not only as single layer but also as a thin film which consists of at least two or more layers as mentioned above.

That from which composition differs, respectively, that from which the crystallized state differs, respectively, etc., is contained in the above-mentioned thin film of two or more layers.

As explained until now, in this invention, although it has shown clearly that the thin film which comprises as the main ingredients at least one or more materials selected from a gallium nitride, an indium nitride, and an aluminum nitride can be formed not only as a single layer but also as a thin film of at least two or more layers, also in the above mentioned thin film which consists of two or more layers and which comprises as the main ingredients at least one or more materials selected from a gallium nitride, an indium nitride, and an aluminum nitride, the thing of arbitrary thickness can form in each thin film layer.

And, in the above mentioned thin film which consists of two or more layers and comprises as the main ingredients at least one or more materials selected from a gallium nitride, an indium nitride, and an aluminum nitride, as for the thin film layer (the thin-film layer which is being formed in the substrate side) which is directly formed on the substrate which consists of a sintered compact which comprises an aluminum nitride as the main ingredients or on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., it is preferred that the thickness is not less than 0.5 nm in order to obtain the single crystal thin film more excellent in crystallinity.

When at least one of the thin film layers which comprise as the main ingredients at least one or more materials selected from a gallium nitride, an indium nitride and an aluminum nitride and which consists of at least two or more layers and are formed on the above-mentioned substrate which consists of a sintered compact which comprises an aluminum nitride as the main ingredients or on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., is a single crystal thin film and the thickness is not less than 0.5 nm, the thing whose crystallinity is not more than 300 seconds as half width of the rocking curve of the X-ray diffraction line from the lattice plane of the Miller Index (002) of the single crystal thin film can be formed.

Moreover, when at least one of the above-mentioned thin film layers which consist of at least two or more layers and which comprise as the main ingredients at least one or more materials selected from a gallium nitride, an indium nitride, and an aluminum nitride is a single crystal thin film and the thickness is not less than 0.3 μm, the single crystal thin film which has the crystallinity, such that the half width of the rocking curve of the X-ray diffraction line from the lattice plane of a Miller Index (002) is not more than 300 seconds, can be formed.

If the substrate on which this single crystal thin film is formed is the sintered compact which comprises an aluminum nitride as the main ingredients, a single crystal thin film excellent in crystallinity not more than 240 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride can be obtained.

Moreover, even when at least one of the above-mentioned thin film layers which consist of at least two or more layers and which comprise as the main ingredients at least one or more materials selected from a gallium nitride, an indium nitride, and an aluminum nitride is a single crystal thin film and the thickness is not less than 3.5 μm, the single crystal thin film which has the crystallinity, such that the half width of the rocking curve of the X-ray diffraction line from the lattice plane of a Miller Index (002) is not more than 300 seconds, can be formed.

If the substrate on which the single crystal thin film layer is formed is a sintered compact which comprises an aluminum nitride as the main ingredients, a single crystal thin film excellent in crystallinity not more than 200 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride is obtained.

A comparatively thick thin film not less than 10 μm which consists of at least two or more layers can also be formed, using the substrate according to this invention which consists of a sintered compact which comprises an aluminum nitride as the main ingredients or various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc.

Even when at least one of the above-mentioned thin film layers which consist of at least two or more layers and which comprise as the main ingredients at least one or more materials selected from a gallium nitride, an indium nitride, and an aluminum nitride is a single crystal thin film and the thickness is not less than 10 μm, the single crystal thin film which has the crystallinity, such that the half width of the rocking curve of the X-ray diffraction line from the lattice plane of a Miller Index (002) is not more than 300 seconds, can be formed.

If the substrate on which the single crystal thin film is formed is a sintered compact which comprises an aluminum nitride as the main ingredients, a single crystal thin film excellent in crystallinity not more than 150 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride is obtained.

As for the thin film which consists of at least two or more layers and which comprises as the main ingredients at least one or more materials selected from a gallium nitride, an indium nitride, and an aluminum nitride and is formed on the substrate according to this invention which consists of a sintered compact which comprises an aluminum nitride as the main ingredients or various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., formation of a thickness of not less than 50 μm is possible enough.

Even when at least one of the above-mentioned thin film layers which consist of at least two or more layers and which comprise as the main ingredients at least one or more materials selected from a gallium nitride, an indium nitride, and an aluminum nitride is a single crystal thin film and the thickness is not less than 50 μm, the single crystal thin film which has the crystallinity, such that the half width of the rocking curve of the X-ray diffraction line from the lattice plane of a Miller Index (002) is not more than 300 seconds, can be formed.

If the substrate on which the single crystal thin film is directly formed is a sintered compact which comprises an aluminum nitride as the main ingredients, since the thing excellent in crystallinity not more than 130 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride can be obtained, it is preferred. As for the thin film layer which consists of at least two or more layers and which comprises as the main ingredients at least one or more materials selected from a gallium nitride, an indium nitride, and an aluminum nitride and is formed directly on the substrate for thin film formation according to this invention, formation of a thickness of about 500 μm is possible enough, and a single crystal thin film with a thickness of 1000 μm is actually obtained.

Even when at least one of the above-mentioned thin film layers which consist of at least two or more layers and which comprise as the main ingredients at least one or more materials selected from a gallium nitride, an indium nitride, and an aluminum nitride is a single crystal thin film and the thickness is the range of 500 μm-1000 μm, the single crystal thin film which has the crystallinity, such that the half width of the rocking curve of the X-ray diffraction line from the lattice plane of a Miller Index (002) is not more than 300 seconds, can be formed.

If the substrate on which this single crystal thin film is formed is the sintered compact which comprises an aluminum nitride as the main ingredients, the thing excellent in crystallinity not more than 130 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride can be obtained.

In this invention, if forming the above mentioned thin film which consists of at least two or more layers and which comprises as the main ingredients at least one or more materials selected from a gallium nitride, an indium nitride, and an aluminum nitride, by using suitably the methods, such as a MOCVD (Metal Organic Chemical Vapor Deposition) method, an MOVPE (Metal Organic Vapor Phase Epitaxy) method, a Hydride VPE (Hydride Vapor Phase Epitaxy) method, a Halide VPE method including a Chloride VPE (Chloride Vapor Phase Epitaxy) method, a Plasma CVD method, other CVD (Chemical Vapor Deposition) methods, or an MBE (Molecular Beam Epitaxy) method, or a laser ablation method using excimer laser, a PLD (pulsed-laser deposition: pulsed laser decomposition) method, etc., or a Sputtering method, etc., the thin film of the target constitution can be obtained.

In this invention, as for the relation between the thickness and crystallinity of the single crystal thin film in the above mentioned thin film layer which consists of at least two or more layers and which comprises as the main ingredients at least one or more materials selected from a gallium nitride, an indium nitride, and an aluminum nitride, not only in what was directly formed on the sintered compact which comprises an aluminum nitride as the main ingredients or on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., but also in the single crystal thin film formed on the thin film substrate in which the thin film which comprises as the main ingredients at least one or more materials selected from a gallium nitride, an indium nitride, and an aluminum nitride and which has various crystallized states, such as a single crystal, an amorphous state, a polycrystal, and an orientated polycrystal etc., was formed beforehand on the substrate which consists of a sintered compact which comprises an aluminum nitride as the main ingredients or on the substrate which consists of various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., it can obtain the same relation mentioned above between the thickness and crystallinity.

In this invention, as for the single crystal thin film which comprises as the main ingredients at least one or more materials selected from a gallium nitride, an indium nitride, and an aluminum nitride and which is formed on the substrate which consists of a sintered compact which comprises an aluminum nitride as the main ingredients or on the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., it can be formed not only as single layer or two or more layers of the same ingredient layer but also as a single crystal thin film of at least two or more layers which consists of a different ingredient.

In this invention, in the substrate which consists of a sintered compact which comprises an aluminum nitride as the main ingredients, or in the various sintered compacts which comprise as the main ingredients a ceramic material which has the crystal system which can be classified as a hexagonal system, such as a silicon carbide, a silicon nitride, a zinc oxide, and a beryllium oxide etc., and classified as a trigonal system or a hexagonal system, such as an aluminum oxide etc., a single crystal thin film which is constituted with at least two or more layers can be formed as mentioned above, even if at least two or more is what consists of different composition in each single crystal thin film layer, in addition, it can be used suitably.

If this is explained more concretely, when a single crystal thin film comprises three layers, for example, the single crystal thin of two kinds of conditions is contained, such as, what consists of three layers in which the composition of two layers are same and one layer is different, and what consists of three layers in which all the composition is different respectively.

Moreover, for example, when a single crystal thin film comprises four layers, the thin film of three kinds of conditions is contained, such as, what consists of four layers in which the composition of two layers are same and two layers are different respectively, what consists of four layers in which the composition of three layers are same and one layer is different, what consists of four layers in which all the composition is different respectively.

Here, different ingredient means that substantial composition of a single crystal thin film differs, as for the composition of a single crystal thin film, not only what has the difference of the rate of an ingredient which consists of at least one or more materials selected from a gallium nitride, an indium nitride, and an aluminum nitride which are the main ingredients of this single crystal thin film but also the case where the main ingredients of a single crystal thin film is only one kind among a gallium nitride, an indium nitride, and an aluminum nitride and the other ingredient is only a doping agent substantially, etc., for example, are contained.

Speaking more concretely, for example, in the case of what is only a gallium nitride as the main ingredients of a single crystal thin film and contained substantially only a magnesium (Mg) as a doping agent in addition to this, that from which the composition ratio of a gallium nitride and magnesium differs is also contained.

Or similarly, for example, in the case of what is only an aluminum nitride as the main ingredients of a single crystal thin film and contained substantially only a silicon (Si) as a doping agent in addition to this, that from which the composition ratio of an aluminum nitride and silicon differs is also contained.

In this invention, as mentioned above, on the substrate which consists of a sintered compact which comprises an aluminum nitride as the main ingredients or on the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., although the single crystal thin film which comprises as the main ingredients at least one or more materials selected from a gallium nitride, an indium nitride, and an aluminum nitride can form not only the layer of the same ingredient as single layer or in two or more layers, but also the layer which consists of a different ingredient as a single crystal thin film of at least two or more layers, even if that are what formed the same ingredient in two or more layers and what formed what is a different ingredient in two or more layers, what is the crystallinity not more than 300 seconds as half width of the rocking curve of the X-ray diffraction line from the lattice plane of the Miller Index (002) of the single crystal thin film of each respectively formed layer is obtained.

If the substrate in which this single crystal thin film is formed directly is the sintered compact which comprises an aluminum nitride as the main ingredients, since the thing excellent in crystallinity not more than 150 seconds as half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride is obtained, it is preferred.

In this invention, as for the factor which gives to the crystallinity of the thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal, an is formed on the substrate which consists of so-called various ceramics, such as the sintered compact which comprises an aluminum nitride as the main ingredients or the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., if what has been explained until now is summarized, it will be classified as follows.

In the substrate to be used, such as, 1) Quality of the material of a ceramic (the difference of the sintered compact which comprises an aluminum nitride as the main ingredients, or the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.), 2) Composition of a ceramic (purity and content of the main ingredients, content of the additives or impurities, etc.), 3) Light transmittance of a ceramic, 4) Magnitude of a ceramic particle, 5) Density of a ceramic, 6) Thickness of a ceramic, 7) The firing conditions of a ceramic, 8) The surface smooth nature of a substrate, and as for a thin film, 9) The constitution of a thin film (single layer or multilayer constitution of two or more layers, etc.), 10) Thickness of a thin film, 11) The formation conditions of a thin film (methods for forming thin film, such as MOCVD, a Chloride VPE, or Sputtering, or substrate temperature, etc.), etc. The following points are mentioned as a factor which seldom affects the crystallinity of the thin film formed on the above-mentioned ceramic substrate.

It is, 1) whether it has the conduction via in the ceramic substrate (irrespective of the existence of a conduction via, there is no effect in the crystallinity of the thin film formed in a substrate not much),

2) Composition of a thin film (if it is the composition which comprises as the main ingredients at least one or more materials selected from a gallium nitride, an indium nitride, and an aluminum nitride, formation in all combination is possible without crystallinity is influenced, and the thin film of various doping ingredient content can also be formed without crystallinity is influenced), etc.

In this invention, if manufacturing the substrate for thin film formation for forming the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., and the thin film substrate in which this thin film was formed, the quality of the material of the sintered compact which comprises an aluminum nitride as the main ingredients and the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., which are used as a substrate, is important.

Among those, about the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., what was manufactured using the conventional method can also be used satisfactorily.

That is, by firing the powder compact in which the fine powder which comprises as the main ingredients a silicon carbide, a silicon nitride, a zinc oxide, a beryllium oxide, and an aluminum oxide, etc. was mixed suitably with sintering aid, the binder, and the dispersant, etc. at high temperature, it is what was made into a sintered compact.

Although it depends for firing conditions on the grain size or composition of the raw material powder of various ceramic materials respectively, the temperature, such as, for example, 1500 degrees C.-2500 degrees C. in the case of silicon carbide, 1600 degrees C.-2100 degrees C. in the case of silicon nitride, 1100 degrees C.-1700 degrees C. in the case of zinc oxide, 1100 degrees C.-2000 degrees C. in the case of beryllium oxide, 1100 degrees C.-2000 degrees C. in the case of aluminum oxide, etc. is used as firing temperature.

As an ambient atmosphere at the time of firing, for non-oxides, such as silicon carbide and silicon nitride, etc., the non-oxidizing atmosphere which comprises as the main ingredients argon, helium, nitrogen, hydrogen, carbon monoxide, and carbon, etc., the decompression condition smaller than 760 Torr or the high vacuum condition of not more than 1×10⁻³ Torr are used, as for oxides, such as a zinc oxide, beryllium oxide, and an aluminum oxide etc., the oxidizing atmosphere which comprises as the main ingredients air, oxygen, and carbon dioxide, etc. besides the above-mentioned non-oxidizing atmosphere, a decompression condition, or a high vacuum condition is used.

As a pressure at the time of firing, the pressure of around 1 Kg/cm² (760 Torr) used in normal pressure sintering, and the pressure of about 5000 Kg/cm² used by pressurization firing, hot press, HIP, etc. besides the above-mentioned decompression condition or a high vacuum condition, can use satisfactorily.

As the composition of the above-mentioned various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., even if it is what contains only the main ingredients of each material excluding additives, such as sintering aid, or what suitably contains one of ingredients, such as sintering aid, a black-ized agent, or impurities in a raw material or what contains two or more other than the main ingredients, they can be used satisfactorily.

For example, as composition of the sintered compact which comprises a silicon carbide as the main ingredients, that is, what consists only of SiC substantially, or what contains one of these ingredients or what contains two or more, such as a carbon ingredient, boron ingredient such as or B, and B4C and BN, a rare-earth-elements ingredient such as Y₂O₃, Er₂O₃, Yb₂O₃, an alkaline earth metal ingredient such as BeO, MgO, CaO, SrO, BaO, aluminum ingredient such as Al₂O₃, or silicon ingredient such as SiO₂, etc.

As composition of the sintered compact which comprises a silicon nitride as the main ingredients, that is, what consists only of Si₃N₄ substantially, or what contains one of these ingredients or what contains two or more, such as a rare-earth-elements ingredient such as Y₂O₃, Er₂O₃, Yb₂O₃, an alkaline earth metal ingredient such as BeO, MgO, CaO, SrO, BaO, aluminum ingredient such as Al₂O₃, silicon ingredient such as SiO₂, black-ized promotion ingredient such as carbon, molybdenum, and tungsten, or a transition-metals ingredient such as TiO₂, Cr₂O₃, MnO, CoO, NiO, Fe₂O₃, etc.

As composition of the sintered compact which comprises a zinc oxide as the main ingredients, that is, what consists only of ZnO substantially, or what contains one of these ingredients or what contains two or more, such as a rare-earth-elements ingredient such as Y₂O₃, Er₂O₃, Yb₂O₃, an alkaline earth metal ingredient such as BeO, MgO, CaO, SrO, BaO, aluminum ingredient such as Al₂O₃, silicon ingredient such as SiO₂, or a transition-metals ingredient such as TiO₂, Cr₂O₃, MnO, CoO, NiO, Fe₂O₃, etc.

As composition of the sintered compact which comprises a beryllium oxide as the main ingredients, that is, what consists only of BeO substantially, or what contains one of these ingredients or what contains two or more, such as a rare-earth-elements ingredient such as Y₂O₃, Er₂O₃, Yb₂O₃, an alkaline earth metal ingredient such as MgO, CaO, SrO, BaO, aluminum ingredient such as Al₂O₃, silicon ingredient such as SiO₂, or transition-metals ingredient such as TiO₂, Cr₂O₃, MnO, CoO, NiO, Fe₂O₃, etc.

As composition of the sintered compact which comprises an aluminum oxide as the main ingredients, that is, what consists only of Al₂O₃ substantially, or what contains one of these ingredients or what contains two or more, such as a rare-earth-elements ingredient such as Y₂O₃, Er₂O₃, Yb₂O₃,an alkaline earth metal ingredient such as BeO, MgO, CaO, SrO, BaO, silicon ingredient such as SiO₂, or a transition-metals ingredient such as TiO₂, Cr₂O₃, MnO, CoO, NiO, Fe₂O₃, etc.

It has explained until now, when the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., are used as a substrate, the crystallinity of the single crystal thin film which comprises as the main ingredients at least one or more materials selected from a gallium nitride, an indium nitride, and an aluminum nitride directly formed on this substrate can be raised by raising the surface smooth nature of this substrate.

However, even if average surface roughness Ra is about 2 nm as smooth nature of this substrate, it is easy to become what is more than 200 seconds as half width of the rocking curve of the X-ray diffraction line from the lattice plane of the Miller Index (002) of this single crystal thin film.

In addition, by using as a substrate the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on this substrate, then the single crystal thin film which comprises as the main ingredients at least one or more materials selected from a gallium nitride, an indium nitride, and an aluminum nitride is formed furthermore on it, the crystallinity of this single crystal thin film can be raised.

The single crystal thin film which has still higher crystallinity can produce by optimizing composition of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

As mentioned above, while the single crystal thin film which comprises as the main ingredients at least one or more materials selected from a gallium nitride, an indium nitride, and an aluminum nitride and is directly formed on the substrate which consists of a sintered compact which comprises a zinc oxide as the main ingredients is not necessarily able to become the thing excellent in crystallinity by being easy to be influenced of the surface smooth nature of this substrate etc., if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on this substrate which consists of a sintered compact which comprises a zinc oxide as the main ingredients and the single crystal thin film which comprises as the main ingredients at least one or more materials selected from a gallium nitride, an indium nitride, and an aluminum nitride is formed furthermore on it, since it is getting harder to be influenced by the surface smooth nature of this substrate etc., the crystallinity of this single crystal thin film can become what is further excellent.

That is, if the single crystal thin film which comprises as the main ingredients at least one or more materials selected from a gallium nitride, an indium nitride, and an aluminum nitride is formed directly, by using the sintered compact which comprises a zinc oxide as the main ingredients as a substrate, this single crystal thin film will not necessarily become the thing comparatively excellent in crystallinity not more than 200 seconds as half width of the rocking curve of the X-ray diffraction line from the lattice plane of the Miller Index (002).

On the other hand, by using the sintered compact which comprises a zinc oxide as the main ingredients as a substrate, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand, then the single crystal thin film which comprises as the main ingredients at least one or more materials selected from a gallium nitride, an indium nitride, and an aluminum nitride is formed furthermore on it, the single crystal thin film which is comparatively excellent in crystallinity, such that the half width of the rocking curve of the X-ray diffraction line from the lattice plane of a Miller Index (002) is not more than 200 seconds, can be formed.

In the above-mentioned sintered compact which comprises a zinc oxide as the main ingredients, what contains an alkaline earth metal ingredient such as BeO, MgO, and CaO, or a rare-earth-elements ingredient such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, or silicon ingredient such as SiO₂, or transition-metals ingredient such as MnO, CoO, NiO, Fe₂O₃, Cr₂O₃, and TiO₂, or aluminum ingredient, in addition to zinc, is used as a substrate, a thin film of comparatively good crystallinity can form on this substrate in many cases.

Among them, it is preferred to use the sintered compact which contains an aluminum ingredient and comprises a zinc oxide as the main ingredients.

Usually, when the sintered compact which comprises a zinc oxide as the main ingredients and which contains an aluminum ingredient in the range of not more than 45.0 mol % by Al₂O₃ conversion is used as a substrate, a single crystal thin film which comprises as the main ingredients at least one or more materials selected from a gallium nitride, an indium nitride, and an aluminum nitride and is excellent in crystallinity not more than 300 seconds as half width of the rocking curve of the X-ray diffraction line from the lattice plane of a Miller Index (002) can be formed directly on it.

Among the above-mentioned sintered compacts which comprise a zinc oxide as the main ingredients, when what contains an aluminum ingredient in the range of 0.001 mol %-45.0 mol % by Al₂O₃ conversion is used as a substrate, the single crystal thin film which comprises as the main ingredients at least one or more materials selected from a gallium nitride, an indium nitride, and an aluminum nitride and which is excellent in crystallinity not more than 200 seconds as half width of the rocking curve of the X-ray diffraction line from the lattice plane of a Miller Index (002) can form directly on it.

When the sintered compact which comprises a zinc oxide as the main ingredients and which contains an aluminum ingredient in the range of 0.02 mol %-45.0 mol % by Al₂O₃ conversion is used as a substrate, a single crystal thin film excellent in crystallinity not more than 150 seconds as half width of the rocking curve of the X-ray diffraction line from the lattice plane of a Miller Index (002) can be formed directly on this substrate.

When the sintered compact which comprises a zinc oxide as the main ingredients and which contains an aluminum ingredient in the range of 0.08 mol %-35.0 mol % by Al₂O₃ conversion is used as a substrate, a single crystal thin film excellent in crystallinity not more than 130 seconds as half width of the rocking curve of the X-ray diffraction line from the lattice plane of a Miller Index (002) can be formed directly on this substrate.

If, in the sintered compact which comprises a zinc oxide as the main ingredients, what contains at least one or more materials selected from a rare-earth-elements ingredient such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, or a transition-metals ingredient such as MnO, CoO, NiO, Fe₂O₃, Cr₂O₃, and TiO₂, etc. not more than 10 mol % by oxide conversion as the main ingredients is used as a substrate, a single crystal thin film which comprises as the main ingredients at least one or more materials selected from a gallium nitride, an indium nitride, and an aluminum nitride and is excellent in crystallinity not more than 300 seconds as half width of the rocking curve of the X-ray diffraction line from the lattice plane of a Miller Index (002) can be formed directly on this substrate.

Usually, the sintered compact which comprises a zinc oxide as the main ingredients and which contains at least one or more ingredients selected from Fe and Cr not more than 10.0 mol % by oxide conversion (shown by Fe₂O₃ and Cr₂O₃, respectively) as the above-mentioned transition-metals ingredient is desirable, the single crystal thin film which is excellent in crystallinity and comprises as the main ingredients at least one or more materials selected from a gallium nitride, an indium nitride, and an aluminum nitride can form on it by using the sintered compact of such composition as a substrate.

Moreover, when the substrate which consists of the above-mentioned sintered compact which contains an aluminum ingredient and comprises a zinc oxide as the main ingredients is used, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on the substrate which consists of a sintered compact which is a same composition and which contains an aluminum ingredient and comprises a zinc oxide as the main ingredients, and the single crystal thin film which comprises as the main ingredients at least one or more materials selected from a gallium nitride, an indium nitride, and an aluminum nitride is formed furthermore on it, the crystallinity of this single crystal thin film can become the thing which is further superior to the crystallinity of the single crystal thin film which comprises as the main ingredients at least one or more materials selected from a gallium nitride, an indium nitride, and an aluminum nitride and is directly formed on this substrate.

Saying concretely, when the sintered compact which comprises a zinc oxide as the main ingredients and which contains an aluminum ingredient in the range of not more than 45.0 mol % by Al₂O₃ conversion is used as a substrate, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on it, then the single crystal thin film which comprises as the main ingredients at least one or more materials selected from a gallium nitride, an indium nitride, and an aluminum nitride is formed furthermore on it, a single crystal thin film excellent in crystallinity not more than 200 seconds, usually not more than 150 seconds, as half width of the rocking curve of the X-ray diffraction line from the lattice plane of the Miller Index (002) of this single crystal thin film can be formed comparatively easily.

And, when the sintered compact which comprises a zinc oxide as the main ingredients and which contains an aluminum ingredient in the range of 0.001 mol %-45.0 mol % by Al₂O₃ conversion is used as a substrate, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal, etc. is formed beforehand on it, then the single crystal thin film which comprises as the main ingredients at least one or more materials selected from a gallium nitride, an indium nitride, and an aluminum nitride is formed furthermore on it, a single crystal thin film excellent in crystallinity not more than 130 seconds as half width of the rocking curve of the X-ray diffraction line from the lattice plane of the Miller Index (002) of this single crystal thin film can be formed comparatively easily.

And, when the sintered compact which comprises a zinc oxide as the main ingredients and which contains an aluminum ingredient in the range of 0.005 mol %-45.0 mol % by Al₂O₃ conversion is used as a substrate, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on it, then the single crystal thin film which comprises as the main ingredients at least one or more materials selected from a gallium nitride, an indium nitride, and an aluminum nitride is formed furthermore on it, a single crystal thin film excellent in crystallinity not more than 100 seconds as half width of the rocking curve of the X-ray diffraction line from the lattice plane of the Miller Index (002) of this single crystal thin film can be formed comparatively easily.

At this time, the crystallinity of the orientated polycrystalline thin film which comprises as the main ingredients at least one or more materials selected from a gallium nitride, an indium nitride, and an aluminum nitride and forms beforehand on the substrate which consists of a sintered compact which comprises a zinc oxide as the main ingredients and contains the above-mentioned aluminum ingredient in the range of 0.001 mol %-45.0 mol % by Al₂O₃ conversion tends to improve if it is compared with what uses the substrate which consists of a sintered compact which comprises a zinc oxide as the main ingredients and does not contain an aluminum ingredient in the above range, what is not more than 9000 seconds as half width of the rocking curve of the X-ray diffraction line from the lattice plane of the Miller Index (002) of this orientated polycrystalline thin film can form comparatively easily.

And, in the substrate which consists of a sintered compact which comprises a zinc oxide as the main ingredients and which contains an aluminum ingredient in the range of 0.005 mol %-45.0 mol % by Al₂O₃ conversion, the thing of not more than 8000 seconds as half width of the rocking curve of the X-ray diffraction line from the lattice plane of the Miller Index (002) of the orientated polycrystalline thin film which comprises as the main ingredients at least one or more materials selected from a gallium nitride, an indium nitride, and an aluminum nitride and forms beforehand on this substrate can form comparatively easily.

And, in the sintered compact which comprises a zinc oxide as the main ingredients, when what contains at least one or more materials selected from a rare-earth-elements ingredient such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, or a transition-metals ingredient such as MnO, CoO, NiO, Fe₂O₃, Cr₂O₃, and TiO₂, etc. not more than 10 mol % by oxide conversion as the main ingredients is used as a substrate, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal, etc. is formed beforehand on it, then the single crystal thin film which comprises as the main ingredients at least one or more materials selected from a gallium nitride, an indium nitride, and an aluminum nitride is formed furthermore on it, a single crystal thin film excellent in crystallinity not more than 130 seconds as half width of the rocking curve of the X-ray diffraction line from the lattice plane of the Miller Index (002) of this single crystal thin film can be formed comparatively easily.

The sintered compact which comprises a zinc oxide as the main ingredients and which contains at least one or more ingredients selected from Fe and Cr as the above-mentioned transition-metals ingredient not more than 10 mol % by oxide conversion (shown by Fe₂O₃ and Cr₂O₃, respectively) is usually preferred, and the single crystal thin film excellent in crystallinity which comprises as the main ingredients at least one or more materials selected from a gallium nitride, an indium nitride, and an aluminum nitride can form on it by using the sintered compact of such composition as a substrate.

Thus, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on the substrate which consists of a sintered compact which comprises a zinc oxide as the main ingredients, it is effective in raising the crystallinity of the single crystal thin film which is furthermore formed on it and which comprises as the main ingredients at least one or more materials selected from a gallium nitride, an indium nitride, and an aluminum nitride.

The effect is not influenced greatly, the element, for example, the surface smooth nature etc., except composition of the substrate which consists of a sintered compact which comprises a zinc oxide as the main ingredients, for example, even if average surface roughness Ra is not what is not more than 5 nm (namely, even if average surface roughness Ra, such as a substrate of the surface state of as-fired, a substrate of the surface state which carried out lap polish, a substrate of the surface state which carried out blast polish, or a substrate that has carried out specular surface polish, is what is not less than 5 nm), it may be demonstrated.

As for the ingredients other than a zinc in a sintered compact which comprises a zinc oxide as the main ingredients, it is rare that especially the effect of an aluminum ingredient which gives to the crystallinity of a single crystal thin film decreases, even if at least one or more metal ingredients other than an aluminum ingredient are contained in this sintered compact which comprises a zinc oxide as the main ingredients, for example, alkaline earth metal ingredients such as BeO, MgO, and CaO, or rare-earth elements ingredients such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, or silicon ingredients such as SiO₂, or transition-metals ingredients such as MnO, CoO, NiO, Fe₂O₃, Cr₂O₃, and TiO₂.

Although when the sintered compact which comprises a zinc oxide as the main ingredients and contains an aluminum ingredient not more than 45.0 mol % by Al₂O₃ conversion is used as a substrate, it is not necessarily clear about the cause whose single crystal thin film which is formed on the substrate becomes what has such high crystallinity, but this inventor thinks as follows.

While the sintered compact which comprises a zinc oxide as the main ingredients and does not contain an aluminum ingredient is usually presenting white or yellow white, the sintered compact which comprises a zinc oxide as the main ingredients containing an aluminum ingredient is usually colored into blue and has the tendency to increase coloration nature according to increase of the content of an aluminum ingredient.

This inventor is guessing that coloration is carried out to the above-mentioned blue, in order that aluminum ion which exists in a zinc oxide may enter to the crystal lattice of a zinc oxide, may be replaced by Zn ion and may form a donor level, it changes in the direction where the size of this zinc oxide crystal becomes small by substitute with Zn ion under zinc oxide crystal by the above-mentioned aluminum ion (that is, a lattice constant becomes small), when growth of the thin film which comprises as the main ingredients at least one or more materials selected from a gallium nitride, an indium nitride, and an aluminum nitride is started, the thin film crystal growth direction will be easy to arrange (epitaxial growth possibility increases spontaneously), as a result, when the sintered compact which comprises a zinc oxide as the main ingredients and which contains such an aluminum ingredient is used as a substrate, the single crystal thin film which comprises as the main ingredients at least one or more materials selected from a gallium nitride, an indium nitride, and an aluminum nitride excellent in crystallinity becomes is easy to be formed on it.

Although the conductivity of the sintered compact which comprises a zinc oxide as the main ingredients and which does not contain an aluminum ingredient is usually small, the conductivity of the sintered compact which comprises as the main ingredients the zinc oxide which contains the above-mentioned aluminum ingredient in the range of not more than 45.0 mol % by Al₂O₃ conversion improves.

Speaking concretely, the conductivity of the sintered compact which comprises a zinc oxide as the main ingredients and which contains an aluminum ingredient in the range of 0.001 mol %-45.0 mol % by Al₂O₃ conversion improving, for example, what has at least not more than 1×10² Ω·cm as specific resistance in room temperature is easy to obtain.

In he case of the sintered compact which comprises a zinc oxide as the main ingredients and which contains an aluminum ingredient in the range of 0.005 mol %-45.0 mol % by Al₂O₃ conversion, since what has at least not more than 1×10¹ Ω·cm as the specific resistance in room temperature is easy to obtain, it becomes possible to use this sintered compact as a substrate without a conduction via, it is desirable.

In he case of the sintered compact which comprises a zinc oxide as the main ingredients and which contains an aluminum ingredient in the range of 0.02 mol %-45.0 mol % by Al₂O₃ conversion, since what has at least not more than 1×10⁰ Ω·cm as the specific resistance in room temperature is easy to obtain, it becomes possible to use this sintered compact as a substrate without a conduction via, it is more desirable.

In he case of the sintered compact which comprises a zinc oxide as the main ingredients and which contains an aluminum ingredient in the range of 0.08 mol %-45.0 mol % by Al₂O₃ conversion, since what has at least not more than 1×10⁰ Ω·cm as the specific resistance in room temperature is easy to obtain, it becomes possible to use this sintered compact as a substrate without a conduction via, it is still more desirable.

In he case of the sintered compact which comprises a zinc oxide as the main ingredients and which contains an aluminum ingredient in the range of 0.2 mol %-25.0 mol % by Al₂O₃ conversion, what has at least not more than 1×10⁻² Ω·cm as the specific resistance in room temperature is easy to obtain, and what has the lower specific resistance which is about 1-2×10⁻³ Ω·cm is also obtained.

Since especially the sintered compact which comprises a zinc oxide as the main ingredients and which has such conductivity does not need to provide the conduction via for connecting the up-and-down surface of a substrate electrically, it is preferred.

In the above-mentioned sintered compact which comprises a zinc oxide as the main ingredients, even if at least one or more ingredients selected from alkaline earth metal ingredients such as BeO, MgO, and CaO, or transition-metals ingredients such as MnO, CoO, NiO, Fe₂O₃, Cr₂O₃, and TiO₂, or silicon ingredients such as SiO₂, or rare-earth elements ingredients such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, etc., were contained in addition to the aluminum ingredient, there are few degrees by which conductivity is spoiled.

As ingredients other than the aluminum contained in the above-mentioned sintered compact which comprises a zinc oxide as the main ingredients, as long as the degree by which conductivity is spoiled is small, it may be what kind of content.

Usually, if a content of ingredients other than this aluminum is not more than 10.0 mol % by oxide conversion, since the degree by which conductivity is spoiled is small, it is desirable.

It is possible to obtain the sintered compact which comprises a zinc oxide as the main ingredients and which has conductivity by what contains not only an aluminum ingredient but also at least one or more ingredients selected from a rare-earth elements ingredient, such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, or a transition-metals ingredient such as MnO, CoO, NiO, Fe₂O₃, Cr₂O₃, and TiO₂, not more than 10 mol % by oxide conversion as an ingredient other than zinc.

Usually, the sintered compact which comprises a zinc oxide as the main ingredients and which contains at least one or more ingredients selected from Fe and Cr as the above-mentioned transition-metals ingredient not more than 10 mol % by oxide conversion is desirable, by using the sintered compact of such composition as a substrate, the single crystal thin film excellent in crystallinity which comprises as the main ingredients at least one or more materials selected from a gallium nitride, an indium nitride, and an aluminum nitride can form on it.

Although the above-mentioned sintered compact which comprises a zinc oxide as the main ingredients can produce what has comparatively high optical transmissivity by firing in ambient atmospheres, such as reduced atmosphere containing CO, H₂, etc., or a non-oxidizing atmosphere containing Ar, He, N₂, etc., or a decompression condition, or a high pressure condition by hot pressing etc., even if it performs firing in the atmosphere of ordinary pressure without using such an ambient atmosphere especially, what has comparatively high optical transmissivity is producible.

That is, even if the sintered compact which comprises a zinc oxide as the main ingredients is what kind of composition, what has optical permeability to ultraviolet light with a wavelength not less than 380 nm, visible light, and light with wavelength longer than visible light can produce.

For example, even if the sintered compact which comprises a zinc oxide as the main ingredients is what kind of composition, the thing whose optical transmissivity is not less than 1% can produce.

Usually, in the case of the sintered compact which contains a zinc oxide ingredient not less than 55.0 mol % by ZnO conversion and comprises a zinc oxide as the main ingredients, the thing whose optical transmissivity is not less than 1% can produce.

For example, in the case of the sintered compact which comprises as the main ingredients the zinc oxide which consists of only ZnO substantially by firing without using an additive, the thing whose optical transmissivity is not less than 10% can produce.

In this invention, the optical transmissivity of the sintered compact which comprises a zinc oxide as the main ingredients is a thing in the light of the range of 200 nm-800 nm wavelength at least.

The above-mentioned optical transmissivity is measured with light of a wavelength 605 nm.

In this invention, unless reference is made especially, the above-mentioned measured value was used for the optical transmissivity of the sintered compact which comprises a zinc oxide as the main ingredients from now on.

As mentioned above, in the case of the sintered compact which comprises a zinc oxide as the main ingredients and which contains an aluminum ingredient in the range of not more than 45.0 mol % by Al₂O₃ conversion, not only what has conductivity, but also what has optical permeability can produce as mentioned above.

As optical transmissivity of the above-mentioned sintered compact which comprises a zinc oxide as the main ingredients containing an aluminum ingredient, usually, the thing whose optical transmissivity is not less than 10% can produce.

As mentioned above, in the case of the sintered compact which comprises a zinc oxide as the main ingredients and which contains an aluminum ingredient in the range of 0.001 mol %-45.0 mol % by Al₂O₃ conversion, as mentioned above, not only what has conductivity but also what improved to optical transmissivity not less than 20% is easy to be obtained, and what is the optical transmissivity not less than 30%, not less than 40%, not less than 50%, not less than 60%, and not less than 80% is easy to be produced.

The above-mentioned optical transmissivity is not the straight line transmittance of a transparent body such as glass etc., it means total transmittance like optical transmissivity of the sintered compact which comprises an aluminum nitride as the main ingredients.

If it explains in detail, even if metal ingredients, such as an alkaline earth metal ingredient such as BeO, MgO, and CaO, or a transition-metals ingredient such as MnO, CoO, NiO, Fe₂O₃, Cr₂O₃, and TiO₂, or silicon ingredient such as SiO₂, or a rare-earth elements ingredient such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, etc., were contained in addition to the aluminum ingredient in such sintered compact which comprises a zinc oxide as the main ingredients and which has optical permeability, it is rare that an optical permeability or conductivity decreases.

Among them, for example, even if it is the sintered compact which comprises a zinc oxide as the main ingredients and contains simultaneously an aluminum ingredient, such as Al₂O₃, and not more than 10.0 mol % of at least one or more ingredients selected from a rare-earth-elements ingredient such as Sc, Y, La, Ce, Pr, Nd, Pm, Sm, Eu, Gd, Tb, Dy, Ho, Er, Tm, Yb, and Lu, by oxide conversion, what has the optical transmissivity not less than 20% can be obtained.

Moreover, in the case of the above mentioned sintered compact which comprises a zinc oxide as the main ingredients and contains a rare-earth-elements ingredient in the range of 0.0002 mol %-10.0 mol %, optical transmissivity becomes easy to improve furthermore, what has the optical transmissivity not less than 30% becomes easy to be obtained, what is a maximum of 84% was also obtained in this invention.

Namely, in the case of the sintered compact which comprises a zinc oxide as the main ingredients and which contains an aluminum ingredient not more than 45.0 mol % by Al₂O₃ conversion and contains simultaneously at least one or more ingredients selected from a rare-earth-elements ingredient in the range of 0.0002 mol %-10.0 mol % in total by oxide conversion, what is the optical transmissivity not less than 30% is easy to be obtained.

And, in the case of the sintered compact which comprises a zinc oxide as the main ingredients and which contains an aluminum ingredient not more than 45.0 mol % by Al₂O₃ conversion and further contains at least one or more ingredients selected from a rare-earth-elements ingredient in the range of 0.0006 mol %-6.0 mol % in total by oxide conversion, what is the optical transmissivity not less than 40% is easy to be obtained.

And, in the case of the sintered compact which comprises a zinc oxide as the main ingredients and which contains an aluminum ingredient not more than 45.0 mol % by Al₂O₃ conversion and further contains at least one or more ingredients selected from a rare-earth-elements ingredient in the range of 0.001 mol %-6.0 mol % in total by oxide conversion, what is the optical transmissivity not less than 50% is easy to be obtained.

And, in the case of the sintered compact which comprises a zinc oxide as the main ingredients and which contains an aluminum ingredient not more than 45.0 mol % by Al₂O₃ conversion and further contains at least one or more ingredients selected from a rare-earth-elements ingredient in the range of 0.002 mol %-3.0 mol % in total by oxide conversion, what is the optical transmissivity not less than 60% is easy to be obtained.

The oxide used for conversion of the content of a rare-earth-elements ingredient contained in the above-mentioned sintered compact which comprises a zinc oxide as the main ingredients means Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, Lu₂O₃.

Moreover, as for a content of an aluminum ingredient in the above-mentioned sintered compact which comprises a zinc oxide as the main ingredients and contains simultaneously an aluminum ingredient and a rare-earth-elements ingredient, it is preferred that it is the range of 0.001 mol %-45.0 mol % by Al₂O₃ conversion in order to raise optical permeability.

Thus, in the case of the sintered compact which comprises a zinc oxide as the main ingredients and which contains an aluminum ingredient and a rare-earth-elements ingredient simultaneously what is more excellent in optical permeability is easy to be obtained, it is rare to damage conductivity by containing an aluminum ingredient and a rare-earth-elements ingredient simultaneously.

Even when the above-mentioned sintered compact which comprises a zinc oxide as the main ingredients and which has the comparatively high optical transmissivity and contains simultaneously a rare-earth-elements ingredient in addition to an aluminum ingredient is used as a substrate, the crystallinity of the orientated polycrystalline thin film which comprises as the main ingredients at least one or more materials selected from a gallium nitride, an indium nitride, and an aluminum nitride or the single crystal thin film which comprises as the main ingredients at least one or more materials selected from a gallium nitride, an indium nitride, and an aluminum nitride and is formed on this substrate is the usually same degree if it is compared with what used as a substrate the sintered compact which comprises a zinc oxide as the main ingredients and does not contain substantially a rare-earth-elements ingredient but contains an aluminum ingredient.

There are few variations of crystallinity lowering greatly.

As mentioned above, in the case of the sintered compact which comprises a zinc oxide as the main ingredients containing an aluminum ingredient, what has comparatively high optical transmissivity with conductivity can produce comparatively easily.

As mentioned above, in the case of the sintered compact which comprises a zinc oxide as the main ingredients and which contains an aluminum ingredient and a rare-earth-elements ingredient simultaneously, what has higher optical transmissivity with conductivity can produce comparatively easily.

If a light emitting device is produced by using the sintered compact which comprises a ceramic material as the main ingredients and has the conductivity as a substrate, such as the above zinc oxides etc., it has the feature that the light emitting device of the form of arranging an electrode up and down, without forming a conduction via in a substrate, and performing the electric connection of an electrode and a device can produce.

If it is not more than 1×10² Ω·cm as specific resistance in the room temperature of this sintered compact when using the sintered compact which comprises a ceramic material as the main ingredients and has conductivity as a substrate, even if it is the light emitting device of the form where the electrode was arranged up and down, electric power sufficient by little loss can be supplied.

As specific resistance in the room temperature of the sintered compact which has conductivity, what is not more than 1×10¹ Ω·cm is preferred in room temperature, what is not more than 1×10⁰ Ω·cm is more preferred, and what is 1×10⁻¹ Ω·cm is still more preferred.

In this invention, as mentioned above, while the single crystal thin film which comprises as the main ingredients at least one or more materials selected from a gallium nitride, an indium nitride, and an aluminum nitride and is directly formed on the substrate which consists of a sintered compact which comprises a beryllium oxide as the main ingredients cannot necessarily become the thing excellent in crystallinity by being easy to be influenced of the surface smooth nature of this substrate etc., if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on this substrate which consists of a sintered compact which comprises a beryllium oxide as the main ingredients and the single crystal thin film which comprises as the main ingredients at least one or more materials selected from a gallium nitride, an indium nitride, and an aluminum nitride is formed furthermore on it, since it is getting harder to be influenced by the surface smooth nature of this substrate etc. the crystallinity of this single crystal thin film can become what is further excellent.

That is, if the single crystal thin film which comprises as the main ingredients at least one or more materials selected from a gallium nitride, an indium nitride, and an aluminum nitride is formed directly by using the sintered compact which comprises a beryllium oxide as the main ingredients as a substrate, the half width of the rocking curve of the X-ray diffraction line from the lattice plane of the Miller Index (002) of this single crystal thin film will not necessarily become the thing comparatively excellent in crystallinity not more than 200 seconds.

On the other hand, by using the sintered compact which comprises a beryllium oxide as the main ingredients as a substrate, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand, then the single crystal thin film which comprises as the main ingredients at least one or more materials selected from a gallium nitride, an indium nitride, and an aluminum nitride is formed furthermore on it, the thing comparatively excellent in crystallinity not more than 200 seconds as half width of the rocking curve of the X-ray diffraction line from the lattice plane of the Miller Index (002) of this single crystal thin film can be formed.

In the above-mentioned sintered compact which comprises a beryllium oxide as the main ingredients, when what contains at least one or more ingredients selected from a magnesium ingredient, a calcium ingredient, and a silicon ingredient in addition to beryllium is used as a substrate, a comparatively good crystalline thin film can form on this substrate.

Usually, when the sintered compact which comprises a beryllium oxide as the main ingredients and which contains at least one or more ingredients selected from a magnesium ingredient, a calcium ingredient, and a silicon ingredient, in the range of not more than 35.0 mol % in total by oxide conversion is used as a substrate, a single crystal thin film which comprises as the main ingredients at least one or more materials selected from a gallium nitride, an indium nitride, and an aluminum nitride and is excellent in crystallinity not more than 300 seconds as half width of the rocking curve of the X-ray diffraction line from the lattice plane of a Miller Index (002) can be formed directly on the substrate.

In the above-mentioned sintered compact which comprises a beryllium oxide as the main ingredients, when what contains at least one or more ingredients selected from a magnesium ingredient, a calcium ingredient, and a silicon ingredient, in the range of 0.0002 mol %-35.0 mol % in total by oxide conversion is used as a substrate, a single crystal thin film which comprises as the main ingredients at least one or more materials selected from a gallium nitride, an indium nitride, and an aluminum nitride and is excellent in crystallinity not more than 200 seconds as half width of the rocking curve of the X-ray diffraction line from the lattice plane of a Miller Index (002) can be formed directly on the substrate.

When the sintered compact which comprises a beryllium oxide as the main ingredients and which contains at least one or more ingredients selected from a magnesium ingredient, a calcium ingredient, and a silicon ingredient, in the range of 0.004 mol %-35.0 mol % in total by oxide conversion is used as a substrate, a single crystal thin film excellent in crystallinity not more than 150 seconds as half width of the rocking curve of the X-ray diffraction line from the lattice plane of a Miller Index (002) can be formed directly on this substrate. When the sintered compact which comprises a beryllium oxide as the main ingredients and which contains at least one or more ingredients selected from a magnesium ingredient, a calcium ingredient, and a silicon ingredient, in the range of 0.015 mol %-25.0 mol % in total by oxide conversion is used as a substrate, a single crystal thin film excellent in crystallinity not more than 130 seconds as half width of the rocking curve of the X-ray diffraction line from the lattice plane of a Miller Index (002) can be formed directly on this substrate.

In the above-mentioned sintered compact which comprises a beryllium oxide as the main ingredients, the oxide used for conversion of the content of a magnesium ingredient, a calcium ingredient, and a silicon ingredient is MgO in the case of a magnesium ingredient, CaO in the case of a calcium ingredient, and SiO₂ in the case of a silicon ingredient.

Hereafter, in this invention, unless reference is made especially, as a compound which is used for oxide conversion of a magnesium ingredient, a calcium ingredient, and a silicon ingredient which are contained in the sintered compact which comprises a beryllium oxide as the main ingredients, it is MgO, CaO, and SiO₂, respectively.

Moreover, when the above-mentioned substrate which consists of a sintered compact which comprises a beryllium oxide as the main ingredients and contains a magnesium ingredient, a calcium ingredient, and a silicon ingredient is used, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on the substrate which consists of a sintered compact comprising a beryllium oxide as the main ingredients and containing the same composition of a magnesium ingredient, a calcium ingredient, and a silicon ingredient, then the single crystal thin film which comprises as the main ingredients at least one or more materials selected from a gallium nitride, an indium nitride, and an aluminum nitride is formed furthermore on it, the crystallinity of this single crystal thin film can become what is further superior to the crystallinity of the single crystal thin film which comprises as the main ingredients at least one or more materials selected from a gallium nitride, an indium nitride, and an aluminum nitride directly formed on this substrate.

Concretely saying, when the sintered compact which comprises a beryllium oxide as the main ingredients and which contains at least one or more ingredients selected from a magnesium ingredient, a calcium ingredient, and a silicon ingredient, in the range of not more than 35.0 mol % in total by oxide conversion is used as a substrate, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on it, then the single crystal thin film which comprises as the main ingredients at least one or more materials selected from a gallium nitride, an indium nitride, and an aluminum nitride is formed furthermore on it, a single crystal thin film excellent in crystallinity not more than 200 seconds, usually not more than 150 seconds, as half width of the rocking curve of the X-ray diffraction line from the lattice plane of the Miller Index (002) of this single crystal thin film can be formed comparatively easily.

And, when the sintered compact which comprises a beryllium oxide as the main ingredients and which contains at least one or more ingredients selected from a magnesium ingredient, a calcium ingredient, and a silicon ingredient, in the range of 0.0002 mol %-35.0 mol % in total by oxide conversion is used as a substrate, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on it, then the single crystal thin film which comprises as the main ingredients at least one or more materials selected from a gallium nitride, an indium nitride, and an -aluminum nitride is formed furthermore on it, a single crystal thin film excellent in crystallinity not more than 130 seconds as half width of the rocking curve of the X-ray diffraction line from the lattice plane of the Miller Index (002) of this single crystal thin film can be formed comparatively easily.

When the sintered compact which comprises a beryllium oxide as the main ingredients and which contains at least one or more ingredients selected from a magnesium ingredient, a calcium ingredient, and a silicon ingredient, in the range of 0.001 mol %-35.0 mol % in total by oxide conversion is used as a substrate, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on it, then the single crystal thin film which comprises as the main ingredients at least one or more materials selected from a gallium nitride, an indium nitride, and an aluminum nitride is formed furthermore on it, a single crystal thin film excellent in crystallinity not more than 100 seconds as half width of the rocking curve of the X-ray diffraction line from the lattice plane of the Miller Index (002) of this single crystal thin film can be formed comparatively easily.

At this time, the crystallinity of the orientated polycrystalline thin film which comprises as the main ingredients at least one or more materials selected from a gallium nitride, an indium nitride, and an aluminum nitride and forms beforehand on the above-mentioned substrate which consists of a sintered compact which comprises a beryllium oxide as the main ingredients and contains at least one or more ingredients selected from a magnesium ingredient, a calcium ingredient, and a silicon ingredient in the range of 0.0002 mol %-35.0 mol % in total by oxide conversion tends to improve if it is compared with what uses the substrate which consists of a sintered compact which comprises a beryllium oxide as the main ingredients and which does not contain a magnesium ingredient, a calcium ingredient, and a silicon ingredient in the above range, what is not more than 9000 seconds as half width of the rocking curve of the X-ray diffraction line from the lattice plane of the Miller Index (002) of this orientated polycrystalline thin film can form comparatively easily.

In the substrate which consists of a sintered compact which comprises a beryllium oxide as the main ingredients and which contains at least one or more ingredients selected from a magnesium ingredient, a calcium ingredient, and a silicon ingredient in the range of 0.001 mol %-35.0 mol % in total by oxide conversion, as for the orientated polycrystalline thin film which comprises as the main ingredients at least one or more materials selected from a gallium nitride, an indium nitride, and an aluminum nitride and forms beforehand on this substrate, what is not more than 8000 seconds as half width of the rocking curve of the X-ray diffraction line from the lattice plane of the Miller Index (002) of the orientated polycrystalline thin film which is formed beforehand on this substrate can form comparatively easily.

Thus, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on the substrate which consists of a sintered compact which comprises a beryllium oxide as the main ingredients, it is effective in raising the crystallinity of the single crystal thin film which is furthermore formed on it and which comprises as the main ingredients at least one or more materials selected from a gallium nitride, an indium nitride, and an aluminum nitride.

The effect is not influenced greatly, the element, for example, the surface smooth nature etc., except composition of the substrate which consists of a sintered compact which comprises a beryllium oxide as the main ingredients, for example, even if average surface roughness Ra is not what is not more than 5 nm (namely, even if average surface roughness Ra, such as a substrate of the surface state of as-fired, a substrate of the surface state which carried out lap polish, a substrate of the surface state which carried out blast polish, or a substrate that has carried out specular surface polish, is what is not less than 5 nm), it may be demonstrated.

As for the at least one or more ingredients selected from a magnesium ingredient, a calcium ingredient, and a silicon ingredient in a sintered compact which comprises a beryllium oxide as the main ingredients, it is rare that the effect of containing them which gives to the crystallinity of a single crystal thin film decreases, even if metal ingredients other than a magnesium ingredient, a calcium ingredient, and a silicon ingredient, for example, alkaline earth metal ingredients such as SrO, and BaO, or rare-earth elements ingredients such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, or others such as MnO, CoO, NiO, Fe₂O₃, Cr₂O₃ and TiO₂, etc., were contained in this sintered compact which comprises a beryllium oxide as the main ingredients.

Although when the sintered compact which comprises a beryllium oxide as the main ingredients and contains at least one or more ingredients selected from a magnesium ingredient, a calcium ingredient, and a silicon ingredient in the range of not more than 35.0 mol % in total by oxide conversion is used as a substrate, it is not necessarily clear about the cause whose single crystal thin film which is formed on the substrate becomes what has such high crystallinity, this inventor thinks that since the above-mentioned ingredient serves as a grain boundary phase, exists between beryllium oxide particles and probably controls extraordinary particle growth of some beryllium oxide particles the sintered compact becomes what has a microstructure of which pores between particles are few and of which the size of a beryllium oxide crystal grain is comparatively equal, the crystalline improvement in the single crystal thin film formed as a result is brought about.

Although the above-mentioned sintered compact which comprises a beryllium oxide as the main ingredients can produce what has comparatively high optical transmissivity by firing in ambient atmospheres, such as reduced atmosphere containing CO, H₂, etc., or a non-oxidizing atmosphere containing Ar, He, N₂, etc., or a decompression condition, or a high pressure condition by hot pressing etc., even if it performs firing in the atmosphere of ordinary pressure without using such an ambient atmosphere especially, what has comparatively high optical transmissivity is producible.

That is, even if the sintered compact which comprises a beryllium oxide as the main ingredients is what kind of composition, what has optical permeability to ultraviolet light with a wavelength not less than 200 nm, visible light, and light with wavelength longer than visible light can produce.

For example, even if the sintered compact which comprises a beryllium oxide as the main ingredients is what kind of composition, the thing whose optical transmissivity is not less than 1% can produce.

Usually, in the case of the sintered compact which contains a beryllium oxide ingredient not less than 65.0 mol % by BeO conversion and comprises a beryllium oxide as the main ingredients, the thing whose optical transmissivity is not less than 1% can produce.

For example, in the case of the sintered compact which comprises a beryllium oxide as the main ingredients and consists of only BeO substantially by firing without using an additive, what is the optical transmissivity not less than 10% can be produced.

In this invention, the optical transmissivity of the sintered compact which comprises a beryllium oxide as the main ingredients is a thing in the light of the range of 200 nm-800 nm wavelength at least.

The above-mentioned optical transmissivity is measured with light of a wavelength 605 nm.

In this invention, unless reference is made especially, the above-mentioned measured value was used for the optical transmissivity of the sintered compact which comprises a beryllium oxide as the main ingredients from now on.

As mentioned above, in the case of the sintered compact which comprises a beryllium oxide as the main ingredients and which contains at least one or more ingredients selected from a magnesium ingredient, a calcium ingredient, and a silicon ingredient, in the range of not more than 35.0 mol % in total by oxide conversion, what is the optical transmissivity not less than 10% can also be produced.

Moreover, as mentioned above, in the case of the sintered compact which comprises a beryllium oxide as the main ingredients and which contains at least one or more ingredients selected from a magnesium ingredient, a calcium ingredient, and a silicon ingredient, in the range of 0.0002 mol %-35.0 mol % in total by oxide conversion, what improved to optical transmissivity not less than 20% is easy to be obtained, and what is the optical transmissivity not less than 30%, not less than 40%, not less than 50%, not less than 60%, and not less than 80% is also easy to be produced.

The above-mentioned optical transmissivity is not the straight line transmittance of a transparent body such as glass etc., it means total transmittance like optical transmissivity of the sintered compact which comprises an aluminum nitride as the main ingredients.

If it explains in detail, even if metal ingredients other than a magnesium ingredient, a calcium ingredient, and a silicon ingredient, such as SrO, BaO, MnO, CoO, NiO, Fe₂O₃, Cr₂O₃, TiO₂, Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, etc., were contained in this sintered compact which comprises a beryllium oxide as the main ingredients, it is rare for an optical permeability to decrease. For example, in the case of the sintered compact which comprises a beryllium oxide as the main ingredients and which contains at least one or more ingredients selected from a magnesium ingredient such as MgO, a calcium ingredient such as CaO, and a silicon ingredient such as SiO₂ and contains simultaneously at least one or more ingredients selected from a rare-earth-elements ingredient, such as Sc, Y, La, Ce, Pr, Nd, Pm, Sm, Eu, Gd, Tb, Dy, Ho, Er, Tm, Yb, and Lu, a total of not more than 5.0 mol % by oxide conversion, what is the optical transmissivity not less than 20% can be obtained.

And, in the case of the above mentioned sintered compact which comprises a beryllium oxide as the main ingredients and contains a rare-earth-elements ingredient in the range of 0.00005 mol %-5.0 mol %, optical transmissivity furthermore becomes easy to improve, what is the optical transmissivity not less than 30% is easy to be obtained, and what is a maximum of 81% was also obtained in this invention.

Namely, in the case of the sintered compact which comprises a beryllium oxide as the main ingredients and which contains at least one or more ingredients selected from a magnesium ingredient, a calcium ingredient, and a silicon ingredient, in the range of not more than 35.0 mol % in total by oxide conversion and contains moreover at least one or more ingredients selected from a rare-earth-elements ingredient in the range of 0.00005 mol %-5.0 mol % in total by oxide conversion, what is the optical transmissivity not less than 30% is easy to be obtained.

In the case of the sintered compact which comprises a beryllium oxide as the main ingredients and which contains at least one or more ingredients selected from a magnesium ingredient, a calcium ingredient, and a silicon ingredient, in the range of not more than 35.0 mol % in total by oxide conversion and contains moreover at least one or more ingredients selected from a rare-earth-elements ingredient in the range of 0.0005 mol %-3.0 mol % in total by oxide conversion, what is the optical transmissivity not less than 40% is easy to be obtained.

In the case of the sintered compact which comprises a beryllium oxide as the main ingredients and which contains at least one or more ingredients selected from a magnesium ingredient, a calcium ingredient, and a silicon ingredient, in the range of not more than 35.0 mol % in total by oxide conversion and contains moreover at least one or more ingredients selected from a rare-earth-elements ingredient in the range of 0.002 mol %-3.0 mol % in total by oxide conversion, what is the optical transmissivity not less than 50% is easy to be obtained.

In the case of the sintered compact which comprises a beryllium oxide as the main ingredients and which contains at least one or more ingredients selected from a magnesium ingredient, a calcium ingredient, and a silicon ingredient, in the range of not more than 35.0 mol % in total by oxide conversion and contains moreover at least one or more ingredients selected from a rare-earth-elements ingredient in the range of 0.005 mol %-3.0 mol % in total by oxide conversion, what is the optical transmissivity not less than 60% is easy to be obtained.

The oxide used for conversion of the content of a rare-earth-elements ingredient contained in the above-mentioned sintered compact which comprises a beryllium oxide as the main ingredients is Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃.

In the above-mentioned sintered compact which comprises a beryllium oxide as the main ingredients and which contains at least one or more ingredients selected from a magnesium ingredient, a calcium ingredient, and a silicon ingredient and contains moreover a rare-earth-elements ingredient, it is preferred that the content of at least one or more ingredients selected from a magnesium ingredient, a calcium ingredient, and a silicon ingredient is the range of 0.0002 mol %-35.0 mol % in total by oxide conversion, in order to raise an optical permeability.

Even when the above-mentioned sintered compact with comparatively high optical transmissivity which comprises a beryllium oxide as the main ingredients and which contains at least one or more ingredients selected from a magnesium ingredient, a calcium ingredient, and a silicon ingredient and contains moreover a rare-earth-elements ingredient simultaneously is used as a substrate, the crystallinity of the orientated polycrystalline thin film which comprises as the main ingredients at least one or more materials selected from a gallium nitride, an indium nitride, and an aluminum nitride or the single crystal thin film which comprises as the main ingredients at least one or more materials selected from a gallium nitride, an indium nitride, and an aluminum nitride and which is formed on this substrate is usually the same degree if it is compared with what used as a substrate the sintered compact which comprises a beryllium oxide as the main ingredients and does not contain substantially a rare-earth-elements ingredient but contains at least one or more ingredients selected from a magnesium ingredient, a calcium ingredient, and a silicon ingredient.

There are few variations of crystallinity lowering greatly.

In this invention, as mentioned above, while the single crystal thin film which comprises as the main ingredients at least one or more materials selected from a gallium nitride, an indium nitride, and an aluminum nitride and is directly formed on the substrate which consists of a sintered compact which comprises an aluminum oxide as the main ingredients cannot necessarily become the thing excellent in crystallinity by being easy to be influenced of the surface smooth nature of this substrate etc., if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on this substrate which consists of a sintered compact which comprises an aluminum oxide as the main ingredients and the single crystal thin film which comprises as the main ingredients at least one or more materials selected from a gallium nitride, an indium nitride, and an aluminum nitride is formed furthermore on it, since it is getting harder to be influenced by the surface smooth nature of this substrate etc. the crystallinity of this single crystal thin film can become what is further excellent.

That is, if the single crystal thin film which comprises as the main ingredients at least one or more materials selected from a gallium nitride, an indium nitride, and an aluminum nitride is formed directly using the sintered compact which comprises an aluminum oxide as the main ingredients as a substrate, the single crystal thin film will not necessarily become the thing comparatively excellent in crystallinity not more than 200 seconds as half width of the rocking curve of the X-ray diffraction line from the lattice plane of the Miller Index (002).

On the other hand, by using the sintered compact which comprises an aluminum oxide as the main ingredients as a substrate, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand, then the single crystal thin film which comprises as the main ingredients at least one or more materials selected from a gallium nitride, an indium nitride, and an aluminum nitride is formed furthermore on it, the thing comparatively excellent in crystallinity not more than 200 seconds as half width of the rocking curve of the X-ray diffraction line from the lattice plane of the Miller Index (002) of this single crystal thin film can be formed.

In the above-mentioned sintered compact which comprises an aluminum oxide as the main ingredients, when what contains at least one or more ingredients selected from a magnesium ingredient, a calcium ingredient, and a silicon ingredient in addition to aluminum is used as a substrate, a comparatively good crystalline thin film can form on this substrate.

Usually, when the sintered compact which comprises an aluminum oxide as the main ingredients and which contains at least one or more ingredients selected from a magnesium ingredient, a calcium ingredient, and a silicon ingredient, in the range of not more than 45.0 mol % in total by oxide conversion is used as a substrate, a single crystal thin film which comprises as the main ingredients at least one or more materials selected from a gallium nitride, an indium nitride, and an aluminum nitride and is excellent in crystallinity not more than 300 seconds as half width of the rocking curve of the X-ray diffraction line from the lattice plane of a Miller Index (002) can be formed directly on the substrate.

In the above-mentioned sintered compact which comprises an aluminum oxide as the main ingredients, when what contains at least one or more ingredients selected from a magnesium ingredient, a calcium ingredient, and a silicon ingredient, in the range of 0.001 mol %-45.0 mol % in total by oxide conversion is used as a substrate, a single crystal thin film which comprises as the main ingredients at least one or more materials selected from a gallium nitride, an indium nitride, and an aluminum nitride and is excellent in crystallinity not more than 200 seconds as half width of the rocking curve of the X-ray diffraction line from the lattice plane of a Miller Index (002) can be formed directly on the substrate.

When the sintered compact which comprises an aluminum oxide as the main ingredients and which contains at least one or more ingredients selected from a magnesium ingredient, a calcium ingredient, and a silicon ingredient, in the range of 0.02 mol %-45.0 mol % in total by oxide conversion is used as a substrate, a single crystal thin film excellent in crystallinity not more than 150 seconds as half width of the rocking curve of the X-ray diffraction line from the lattice plane of a Miller Index (002) can be formed directly on the substrate.

When the sintered compact which comprises an aluminum oxide as the main ingredients and which contains at least one or more ingredients selected from a magnesium ingredient, a calcium ingredient, and a silicon ingredient, in the range of 0.08 mol %-35.0 mol % in total by oxide conversion is used as a substrate, a single crystal thin film excellent in crystallinity not more than 130 seconds as half width of the rocking curve of the X-ray diffraction line from the lattice plane of a Miller Index (002) can be formed directly on the substrate.

In the above-mentioned sintered compact which comprises an aluminum oxide as the main ingredients, the oxide used for conversion of the content of a magnesium ingredient, a calcium ingredient, and a silicon ingredient is MgO in the case of a magnesium ingredient, CaO in the case of a calcium ingredient, and SiO₂ in the case of a silicon ingredient.

Hereafter, in this invention, unless reference is made especially, as a compound which is used for oxide conversion of a magnesium ingredient, a calcium ingredient, and a silicon ingredient which are contained in the sintered compact which comprises an aluminum oxide as the main ingredients, it is MgO, CaO, and SiO₂ respectively.

Moreover, when the above-mentioned substrate which consists of a sintered compact which comprises an aluminum oxide as the main ingredients and which contains a magnesium ingredient, a calcium ingredient, and a silicon ingredient is used, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on the substrate which consists of a sintered compact comprising an aluminum oxide as the main ingredients and containing the same composition of a magnesium ingredient, a calcium ingredient, and a silicon ingredient, then the single crystal thin film which comprises as the main ingredients at least one or more materials selected from a gallium nitride, an indium nitride, and an aluminum nitride is formed furthermore on it, the crystallinity of this single crystal thin film can become what is further superior to the crystallinity of the single crystal thin film which comprises as the main ingredients at least one or more materials selected from a gallium nitride, an indium nitride, and an aluminum nitride directly formed on this substrate.

Saying concretely, when the sintered compact which comprises an aluminum oxide as the main ingredients and which contains at least one or more ingredients selected from a magnesium ingredient, a calcium ingredient, and a silicon ingredient, in the range of not more than 45.0 mol % in total by oxide conversion is used as a substrate, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on it, then the single crystal thin film which comprises as the main ingredients at least one or more materials selected from a gallium nitride, an indium nitride, and an aluminum nitride is formed furthermore on it, a single crystal thin film excellent in crystallinity not more than not more than 200 seconds, usually not more than 150 seconds, as half width of the rocking curve of the X-ray diffraction line from the lattice plane of the Miller Index (002) of this single crystal thin film can be formed comparatively easily.

And, when the sintered compact which comprises an aluminum oxide as the main ingredients and which contains at least one or more ingredients selected from a magnesium ingredient, a calcium ingredient, and a silicon ingredient, in the range of 0.001 mol %-45.0 mol % in total by oxide conversion is used as a substrate, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on it, then the single crystal thin film which comprises as the main ingredients at least one or more materials selected from a gallium nitride, an indium nitride, and an aluminum nitride is formed furthermore on it, a single crystal thin film excellent in crystallinity not more than 130 seconds as half width of the rocking curve of the X-ray diffraction line from the lattice plane of the Miller Index (002) of this single crystal thin film can be formed comparatively easily.

When the sintered compact which comprises an aluminum oxide as the main ingredients and which contains at least one or more ingredients selected from a magnesium ingredient, a calcium ingredient, and a silicon ingredient, in the range of 0.005 mol %-45.0 mol % in total by oxide conversion is used as a substrate, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on it, then the single crystal thin film which comprises as the main ingredients at least one or more materials selected from a gallium nitride, an indium nitride, and an aluminum nitride is formed furthermore on it, a single crystal thin film excellent in crystallinity not more than 100 seconds as half width of the rocking curve of the X-ray diffraction line from the lattice plane of the Miller Index (002) of this single crystal thin film can be formed comparatively easily.

At this time, the crystallinity of the orientated polycrystalline thin film which comprises as the main ingredients at least one or more materials selected from a gallium nitride, an indium nitride, and an aluminum nitride and forms beforehand on the above-mentioned substrate which consists of a sintered compact which comprises an aluminum oxide as the main ingredients and contains at least one or more ingredients selected from a magnesium ingredient, a calcium ingredient, and a silicon ingredient in the range of 0.001 mol %-45.0 mol % in total by oxide conversion tends to improve if it is compared with what uses the substrate which consists of a sintered compact which comprises an aluminum oxide as the main ingredients and does not contain a magnesium ingredient, a calcium ingredient, and a silicon ingredient in the above range, what is not more than 9000 seconds as half width of the rocking curve of the X-ray diffraction line from the lattice plane of the Miller Index (002) of this orientated polycrystalline thin film can form comparatively easily.

In the substrate which consists of a sintered compact which comprises an aluminum oxide as the main ingredients and which contains at least one or more ingredients selected from a magnesium ingredient, a calcium ingredient, and a silicon ingredient, in the range of 0.005 mol %-45.0 mol % in total by oxide conversion, the thing of not more than 8000 seconds as half width of the rocking curve of the X-ray diffraction line from the lattice plane of the Miller Index (002) of the orientated polycrystalline thin film which comprises as the main ingredients at least one or more materials selected from a gallium nitride, an indium nitride, and an aluminum nitride and forms beforehand on this substrate can form comparatively easily.

Thus, if the thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., is formed beforehand on the substrate which consists of a sintered compact which comprises an aluminum oxide as the main ingredients, it is effective in raising the crystallinity of the single crystal thin film which is furthermore formed on it and which comprises as the main ingredients at least one or more materials selected from a gallium nitride, an indium nitride, and an aluminum nitride.

The effect is not influenced greatly, the element, for example, the surface smooth nature etc., except composition of the substrate which consists of a sintered compact which comprises an aluminum oxide as the main ingredients, for example, even if average surface roughness Ra is not what is not more than 5 nm (namely, even if average surface roughness Ra, such as a substrate of the surface state of as-fired, a substrate of the surface state which carried out lap polish, a substrate of the surface state which carried out blast polish, or a substrate that has carried out specular surface polish, is what is not less than 5 nm), it may be demonstrated. As for the at least one or more ingredients selected from a magnesium ingredient, a calcium ingredient, and a silicon ingredient in a sintered compact which comprises an aluminum oxide as the main ingredients, it is rare that the effect of containing them which gives to the crystallinity of a single crystal thin film decreases, even if metal ingredients other than a magnesium ingredient, a calcium ingredient, and a silicon ingredient, for example, alkaline earth metal ingredients such as BeO, SrO, and BaO, or rare-earth elements ingredients such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, or others such as MnO, CoO, NiO, Fe₂O₃, Cr₂O₃ and TiO₂, etc., were contained in this sintered compact which comprises an aluminum oxide as the main ingredients.

Although when the sintered compact which comprises an aluminum oxide as the main ingredients and contains at least one or more ingredients selected from a magnesium ingredient, a calcium ingredient, and a silicon ingredient in the range of not more than 45.0 mol % in total by oxide conversion is used as a substrate, it is not necessarily clear about the cause whose single crystal thin film which is formed on the substrate becomes what has such high crystallinity, this inventor thinks that since the above-mentioned ingredient serves as a grain boundary phase, exists between aluminum oxide particles and probably controls extraordinary particle growth of some aluminum oxide particles the sintered compact becomes what has a microstructure of which pores between particles are few and of which the size of an aluminum oxide crystal grain is comparatively equal, the crystalline improvement in the single crystal thin film formed as a result is brought about.

Although the above-mentioned sintered compact which comprises an aluminum oxide as the main ingredients can produce what has comparatively high optical transmissivity by firing in ambient atmospheres, such as reduced atmosphere containing CO, H₂, etc., or a non-oxidizing atmosphere containing Ar, He, N₂, etc., or a decompression condition, or a high pressure condition by hot pressing etc., even if it performs firing in the atmosphere of ordinary pressure without using such an ambient atmosphere especially, what has comparatively high optical transmissivity is producible.

That is, even if the sintered compact which comprises an aluminum oxide as the main ingredients is what kind of composition, what has optical permeability to ultraviolet light with a wavelength not less than 160 nm, visible light, and light with wavelength longer than visible light can produce.

For example, even if the sintered compact which comprises an aluminum oxide as the main ingredients is what kind of composition, the thing whose optical transmissivity is not less than 1% can produce.

Usually, in the case of the sintered compact which contains an aluminum oxide ingredient not less than 55.0 mol % by Al₂O₃ conversion and comprises an aluminum oxide as the main ingredients, the thing whose optical transmissivity is not less than 1% can produce. For example, in the case of the sintered compact which comprises an aluminum oxide as the main ingredients and consists of only Al₂O₃ substantially by firing without using an additive, what is the optical transmissivity not less than 10% can be produced.

In this invention, the optical transmissivity of the sintered compact which comprises an aluminum oxide as the main ingredients corresponds to the light of the range of 200 nm - 800 nm wavelength at least.

The above-mentioned optical transmissivity is measured with light with a wavelength 605 nm.

In this invention, unless reference is made especially, the above-mentioned measured value was used for the optical transmissivity of the sintered compact which comprises an aluminum oxide as the main ingredients from now on.

Moreover, as mentioned above, at least in the case of the sintered compact which comprises an aluminum oxide as the main ingredients and which contains at least one or more ingredients selected from a magnesium ingredient, such as MgO, a calcium ingredient, such as CaO, and a silicon ingredient, such as SiO₂, in the range of not more than 45.0 mol % in total by oxide conversion among the sintered compact which comprises an aluminum oxide as the main ingredients and contains a magnesium ingredient, a calcium ingredient, and a silicon ingredient, what is the optical transmissivity not less than 10% can also be produced.

Moreover, at least in the case of the sintered compact which comprises an aluminum oxide as the main ingredients and which contains at least one or more ingredients selected from a magnesium ingredient, such as MgO, a calcium ingredient, such as CaO, and a silicon ingredient, such as SiO₂, in the range of 0.001 mol %-45.0 mol % in total by oxide conversion among the sintered compact which comprises an aluminum oxide as the main ingredients and contains a magnesium ingredient, a calcium ingredient, and a silicon ingredient, what improved to optical transmissivity not less than 20% is usually easy to be obtained, and what is the optical transmissivity not less than 30%, not less than 40%, not less than 50%, not less than 60%, and not less than 80% is also easy to be produced.

The above-mentioned optical transmissivity is not the straight line transmittance of a transparent body such as glass etc., it means total transmittance like optical transmissivity of the sintered compact which comprises an aluminum nitride as the main ingredients.

If it explains in detail, even if metal ingredients other than a magnesium ingredient, a calcium ingredient, and a silicon ingredient, such as BeO, MnO, CoO, NiO, Fe₂O₃, Cr₂O₃, TiO₂, Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, etc., were contained in this sintered compact which comprises an aluminum oxide as the main ingredients, it is rare for an optical permeability to decrease. For example, even if it is the sintered compact which comprises an aluminum oxide as the main ingredients and which contains at least one or more ingredients selected from a magnesium ingredient, such as MgO, a calcium ingredient, such as CaO, and a silicon ingredient, such as SiO₂, and contains moreover at least one or more ingredients selected from a rare-earth-elements ingredient, such as Sc, Y, La, Ce, Pr, Nd, Pm, Sm, Eu, Gd, Tb, Dy, Ho, Er, Tm, Yb, and Lu, not more than 10.0 mol % by oxide conversion, what is the optical transmissivity not less than 20% can be obtained.

Moreover, in the case of the above mentioned sintered compact which comprises an aluminum oxide as the main ingredients and contains a rare-earth-elements ingredient in the range of 0.0002 mol %-10.0 mol %, optical transmissivity becomes easy to improve furthermore, what is the optical transmissivity not less than 30% is easy to be obtained, and what is a maximum of 82% was also obtained in this invention.

Namely, in the case of the sintered compact which comprises an aluminum oxide as the main ingredients and which contains at least one or more ingredients selected from a magnesium ingredient, a calcium ingredient, and a silicon ingredient, in the range of not more than 45.0 mol % in total by oxide conversion simultaneously and contains moreover at least one or more ingredients selected from a rare-earth-elements ingredient in the range of 0.0002 mol %-10.0 mol % in total by oxide conversion, what is the optical transmissivity not less than 30% is easy to be obtained.

In the case of the sintered compact which comprises an aluminum oxide as the main ingredients and which contains at least one or more ingredients selected from a magnesium ingredient, a calcium ingredient, and a silicon ingredient, in the range of not more than 45.0 mol % in total by oxide conversion simultaneously and contains moreover at least one or more ingredients selected from a rare-earth-elements ingredient in the range of 0.001 mol %-6.0 mol % in total by oxide conversion, what is the optical transmissivity not less than 40% is easy to be obtained.

In the case of the sintered compact which comprises an aluminum oxide as the main ingredients and which contains at least one or more ingredients selected from a magnesium ingredient, a calcium ingredient, and a silicon ingredient, in the range of not more than 45.0 mol % in total by oxide conversion simultaneously and contains moreover at least one or more ingredients selected from a rare-earth-elements ingredient in the range of 0.005 mol %-6.0 mol % in total by oxide conversion, what is the optical transmissivity not less than 50% is easy to be obtained.

In the case of the sintered compact which comprises an aluminum oxide as the main ingredients and which contains at least one or more ingredients selected from a magnesium ingredient, a calcium ingredient, and a silicon ingredient, in the range of not more than 45.0 mol % in total by oxide conversion simultaneously and contains moreover at least one or more ingredients selected from a rare-earth-elements ingredient in the range of 0.005 mol %-3.0 mol % in total by oxide conversion, what is the optical transmissivity not less than 60% is easy to be obtained.

In the above-mentioned sintered compact which comprises an aluminum oxide as the main ingredients and which contains at least one or more ingredients selected from a magnesium ingredient, a calcium ingredient, and a silicon ingredient and contains moreover a rare-earth-elements ingredient simultaneously, it is preferred that the content of at least one or more ingredients selected from a magnesium ingredient, a calcium ingredient, and a silicon ingredient is the range of 0.001 mol %-45.0 mol % in total by oxide conversion, in order to raise an optical permeability.

As the magnesium ingredient, calcium ingredient, and silicon ingredient which are contained in the above-mentioned sintered compact which comprises an aluminum oxide as the main ingredients with a rare-earth-elements ingredient, usually, it is desirable to use at least two or more of these in order to raise optical transmissivity more.

Including at least two or more ingredients selected from a magnesium ingredient, such as MgO, and a calcium ingredient, such as CaO, and a silicon ingredient, such as SiO₂, means concretely including a magnesium ingredient and a silicon ingredient simultaneously, or includeing a calcium ingredient and a silicon ingredient simultaneously, or including a magnesium ingredient and a calcium ingredient simultaneously, or including three ingredients of a magnesium ingredient, a calcium ingredient, and a silicon ingredient simultaneously.

The oxide used for conversion of the content of a magnesium ingredient, a calcium ingredient, and a silicon ingredient is MgO for a magnesium ingredient, CaO for a calcium ingredient, and SiO₂ for a silicon ingredient respectively.

The oxide used for conversion of the content of a rare-earth-elements ingredient contained in the above-mentioned sintered compact which comprises an aluminum oxide as the main ingredients means Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃.

Even when the above-mentioned sintered compact with comparatively high optical transmissivity which comprises an aluminum oxide as the main ingredients and which contains at least one or more ingredients selected from a magnesium ingredient, a calcium ingredient, and a silicon ingredient and contains moreover a rare-earth-element ingredient simultaneously, or the sintered compact with comparatively high optical transmissivity which comprises an aluminum oxide as the main ingredients and which contains at least one or two or more ingredients selected from a magnesium ingredient, a calcium ingredient, and a silicon ingredient and contains moreover a rare-earth-elements ingredient simultaneously is used as a substrate, the crystallinity of the orientated polycrystalline thin film which comprises as the main ingredients at least one or more materials selected from a gallium nitride, an indium nitride, and an aluminum nitride or the single crystal thin film which comprises as the main ingredients at least one or more materials selected from a gallium nitride, an indium nitride, and an aluminum nitride and which is formed on this substrate is usually the same degree if it is compared with what used the sintered compact which comprises an aluminum oxide as the main ingredients and does not contain substantially a rare-earth-elements ingredient but contains at least one or more ingredients selected from a magnesium ingredient, a calcium ingredient, and a silicon ingredient as a substrate.

There are few variations of crystallinity lowering greatly.

In this invention, as mentioned above, the single crystal thin film which has the high crystallinity which comprises as the main ingredients at least one or more materials selected from a gallium nitride, an indium nitride, and an aluminum nitride is producible by using as a substrate the sintered compact which comprises as the main ingredients a zinc oxide, a beryllium oxide, and an aluminum oxide, respectively.

Therefore, by using such substrate on which the single crystal thin film was formed, a light emitting device is producible by forming a thin film anew on it, or a light emitting device is also producible by using such thin film which has high crystallinity at least as a part of thin film layer which constitutes a light emitting device as it is.

As for the light emitting device which is produced by using as a substrate such sintered compact which comprises as the main ingredients a zinc oxide, a beryllium oxide, and an aluminum oxide, respectively, the thing whose luminous efficiency is at least equivalent or more has been able to provide if it is compared with the light emitting device produced by using a conventional sapphire substrate.

On the other hand, as mentioned above, as for the sintered compact which respectively uses a zinc oxide, a beryllium oxide, and an aluminum oxide as the main ingredients, what has comparatively high optical permeability can be obtained, therefore, the light emitting device is also producible by using as a substrate such sintered compact which has optical permeability which respectively uses a zinc oxide, a beryllium oxide, and an aluminum oxide as the main ingredients.

Since as for the light emitting device which was produced by using such sintered compact which has optical permeability and which respectively uses a zinc oxide, a beryllium oxide, and an aluminum oxide as the main ingredients as a substrate, what is further excellent in luminous efficiency is easy to be obtained, what is more excellent in luminous efficiency can be provided if it is compared with the light emitting device produced by using a conventional sapphire substrate.

Although the reason is not necessarily clear, since a substrate is a sintered compact unlike conventional sapphire etc., reflection decreases at the interface between a substrate and the thin film which constitutes a light emitting device, and the light from a light emitting device is penetrated into a substrate as it is, the light which advanced into the substrate becomes easy to be emitted to the substrate exterior since a substrate has optical permeability, it seems that the luminous efficiency of a light emitting device becomes easy to improve.

It is hard coming to generate reflection at an interface with a surrounding ambient atmosphere, it seems that the light from a light emitting device is easy to be emitted to the device exterior through the thin film layer from a thin film layer which constitutes a light emitting device.

In this invention, unless reference is made especially, as for the optical transmissivity of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., it is expressed with the percentage ratio of the intensity of an incident light and the intensity of a transmitted light which were measured with the spectrophotometer etc. applying the light of predetermined wavelength to the above-mentioned sintered compact sample using the disc-like sample which has 25.4 mm diameter and 0.5 mm thickness and is the state of having ground the surface to the specular plane as well as the sintered compact which comprises an aluminum nitride as the main ingredients.

Unless reference is made especially, as wavelength, usually it is measured using 605 nm.

By setting the above-mentioned test sample to the inside of an integrating sphere, and by collecting all transmitted light, the optical transmissivity in this invention is what calculated as total transmittance which expressed the intensity ratio of this all transmitted light and incident light with percentage.

In addition, as for the performance of various sintered compacts according to this invention which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., even if the optical transmissivity has not measured using the light other than the wavelength of 605nm, if the optical transmissivity to the light with a wavelength 605 nm is grasped, the luminous efficiency of the produced light emitting device when used as a substrate for light emitting device production can be judged, for example.

Optical transmissivity changes with the thickness of a sample, in the above-mentioned various sintered compacts according to this invention which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., when it is actually used as a substrate for thin film formation, a thin film substrate, or a substrate for light emitting device production, it is effective to make thickness of this substrate thin and to raise optical transmissivity, in order to raise the luminous efficiency of a light emitting device, for example.

Usually, it is desirable to use what has the thickness not less than 0.01 mm as a substrate for thin film formation, a thin film substrate, or a substrate for light emitting device production from a point of handling strength.

Since optical transmissivity will tend to decrease if thickness becomes thick, it is preferred to usually use what has the thickness not more than 8.0 mm as the substrate for thin film formation, a thin film substrate, or a substrate for light emitting device production.

In this invention, as for the thickness of the above-mentioned various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., it is effective if the substrate for thin film formation, and a thin film substrate, or the substrates for light emitting device production etc. have optical permeability in the state actually used in the range of at least 0.01 mm-8.0 mm.

That is, as for the thickness of the above-mentioned various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., even if it is the range of at least 0.01 mm-8.0 mm or except it, the optical transmissivity in the state where it is actually used should just be at least 1% or more, for example, even if the thickness is not actually 0.5 mm necessarily as a substrate for light emitting device production, such as 0.1 mm or 2.0 mm etc., if it has optical permeability, for example, if the optical transmissivity is at least not less than 1% the luminous efficiency of the light emitting device produced tends to improve.

Therefore, as for the optical transmissivity of the above-mentioned various sintered compacts according to this invention which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., it is unrelated to the thickness of this sintered compact, and the optical permeability in the condition that this sintered compact is actually used is important, and it means the optical transmissivity in the condition that this sintered compact is actually used.

As for the thickness of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., when it is thinner than 0.5 mm in the state actually used, or when thicker than 0.5 mm, it differs from the optical transmissivity measured at the time of the substrate thickness of 0.5 mm, when thinner than 0.5 mm, optical transmissivity tends to become higher than the optical transmissivity measured at the time of 0.5 mm, and when thicker than 0.5 mm, it tends to become lower than the optical transmissivity measured at the time of 0.5 mm.

In this invention, as mentioned above, it is preferred to use the various sintered compacts which are the optical transmissivity not less than I % in the condition of actually being used and which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

In this invention, not only the above-mentioned sintered compacts which comprise as the main ingredients an aluminum oxide, a zinc oxide, a beryllium oxide, a silicon carbide, and a silicon nitride but also the sintered compacts which comprise as the main ingredients a ceramic material, such as a zirconium oxide, a magnesium oxide, a magnesium aluminate, a titanium oxide, a barium titanate, a lead titanate zirconate, rare-earth oxides for example a yttrium oxide, a thorium dioxide, various ferrites, a mullite, a forsterite, a steatite, and glass ceramics, etc. are used as a substrate, as the main ingredients is used as a substrate, if that whose thin film which comprises as the main ingredients at least one or more materials selected from a gallium nitride, an indium nitride, and an aluminum nitride and has various crystallized states, such as a single crystal, an amorphous state, a polycrystal, and an orientated polycrystal etc., was formed beforehand on this substrate is used as a substrate, since the single crystal thin film which comprises as the main ingredients at least one or more materials selected from a gallium nitride, an indium nitride, and an aluminum nitride can be formed on it, by using such substrate on which the single crystal thin film was formed, a light emitting device is producible by forming a thin film anew on it, or a light emitting device is also producible by using the single crystal thin film formed by doing in this way as at least a part of thin film layer which constitutes a light emitting device as it is.

In this invention, as mentioned above, as for the light emitting device produced using the substrate in which the thin film which comprises as the main ingredients at least one or more materials selected from a gallium nitride, an indium nitride, and an aluminum nitride and which is various crystallized states, such as a single crystal, an amorphous state, a polycrystal, and an orientated polycrystal etc., was formed beforehand on the various sintered compacts which comprise as the main ingredients a ceramic material, such as a silicon carbide, a silicon nitride, a zirconium oxide, a magnesium oxide, a magnesium aluminate, a titanium oxide, a barium titanate, a lead titanate zirconate, rare-earth oxides for example a yttrium oxide, a thorium dioxide, various ferrites, a mullite, a forsterite, a steatite, and glass ceramics etc., then the single crystal thin film which comprises as the main ingredients at least one or more materials selected from a gallium nitride, an indium nitride, and an aluminum nitride is formed furthermore on it, the thing whose luminous efficiency is at least equivalent or more can be provided now if it is compared with the light emitting device produced by using a conventional sapphire substrate.

If it explains in detail, in this invention, not only in the above-mentioned sintered compacts which comprise as the main ingredients an aluminum oxide, a zinc oxide, a beryllium oxide, a silicon carbide, and a silicon nitride but also in the sintered compacts which comprise as the main ingredients a ceramic material, such as a zirconium oxide, a magnesium oxide, a magnesium aluminate, a titanium oxide, a barium titanate, a lead titanate zirconate, rare-earth oxides for example a yttrium oxide, a thorium dioxide, various ferrites, a mullite, a forsterite, a steatite, and glass ceramics etc., it is possible to obtain what has optical permeability.

Saying concretely, as optical transmissivity, what has at least not less than 1% usually not less than 10% can be produced.

As for the above-mentioned sintered compacts which comprise as the main ingredients a ceramic material, such as a zirconium oxide, a magnesium oxide, a magnesium aluminate, a titanium oxide, a barium titanate, a lead titanate zirconate (especially what contains a rare-earth-elements ingredient), rare-earth oxides for example a yttrium oxide, a thorium dioxide, various ferrites, a mullite, a forsterite, a steatite, and glass ceramics etc., what is the optical transmissivity not less than 50% can be produced, what is maximum of not less than 80% can also be produced.

If such various sintered compacts which comprise a ceramic material as the main ingredients and which has optical permeability is used for the substrate for light emitting device production, the luminous efficiency of the light emitting device produced will tend to improve if it is compared with the light emitting device produced by using conventional sapphire etc. as a substrate.

Although the reason is not necessarily clear, since a substrate is a sintered compact unlike conventional sapphire etc., reflection decreases at the interface between a substrate and the thin film which constitutes a light emitting device, and the light from a light emitting device is penetrated into a substrate as it is, the light which advanced into the substrate becomes easy to be emitted to the substrate exterior since a substrate has optical permeability, it seems that the luminous efficiency of a light emitting device becomes easy to improve.

It is hard coming to generate reflection at an interface with a surrounding ambient atmosphere, it seems that the light from a light emitting device is easy to be emitted to the device exterior through the thin film layer from a thin film layer which constitutes a light emitting device.

Among the above-mentioned various sintered compacts which comprise a ceramic material as the main ingredients, in the case of a sintered compact which comprises as the main ingredients a zirconium oxide, a magnesium oxide, a magnesium aluminate, rare-earth oxides for example a yttrium oxide, a thorium dioxide, mullite, and glass ceramics, it is especially excellent in optical permeability, what has optical permeability can be produced comparatively easily, adding sintering aids suitably, by using a conventional method, such as normal pressure sintering (for example, in air, or in reducing gas, such as H₂, or in non-oxidizing gas, such as N₂, or in weak oxidizing gas, such as CO₂), decompression firing, and hot pressing.

Even if it is the normal pressure sintering in air, what is the optical transmissivity not less than 10%, usually optical transmissivity not less than 20% or optical transmissivity not less than 30% is producible.

By firing in hydrogen, or by hot pressing, or by decompression firing etc., what is the optical transmissivity not less than 40%, usually optical transmissivity not less than 50% and optical transmissivity not less than 60% can be produced, and what is the optical transmissivity not less than 80% can also be produced.

In order to raise an optical permeability, for example, as sintering aids, in the case of a zirconium oxide, compounds, such as an oxide containing a rare-earth-elements ingredient, such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, etc., or compounds, such as an oxide containing alkaline earth metal ingredients, such as BeO, MgO, CaO, SrO, and BaO, etc. can be used suitably.

In the case of a magnesium oxide, compounds, such as an oxide containing a rare-earth-elements ingredient, such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, etc., or compounds, such as an oxide containing alkaline earth metal ingredients, such as BeO, CaO, SrO, and BaO, etc., or compounds, such as a fluoride containing alkali metal ingredients, such as LiF, and NaF, etc., or silicon compounds, such as SiO₂, etc., can be used suitably.

In the case of a magnesium aluminate, compounds, such as an oxide containing a rare-earth-elements ingredient, such as Sc₂O₃, Y₂O₃, La₂O₃, CeO₂, Pr6O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, etc., or compounds, such as an oxide containing alkaline earth metal ingredients, such as BeO, MgO, CaO, SrO, and BaO, etc., or silicon compounds, such as SiO₂, etc., can be used suitably.

In the case of rare-earth oxide, such as a yttrium oxide, compounds, such as an oxide containing aluminum ingredient, such as Al₂O₃, etc., compound, such as an oxide which contains at least one or more rare earth ingredients and which is different from the main ingredients selected from Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, etc., or compounds, such as an oxide containing alkaline earth metal ingredients, such as BeO, MgO, CaO, SrO, and BaO, etc., can be used suitably.

In the case of a thorium dioxide, compounds, such as an oxide containing a rare-earth-elements ingredient, such as Sc₂O₃, Y₂O₃, La₂O₃, CeO₂, Pr₆Q₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, etc. or compounds, such as an oxide containing alkaline earth metal ingredients, such as BeO, MgO, CaO, SrO, and BaO, etc., can be used suitably.

In the case of a mullite, compounds, such as an oxide containing a rare-earth-elements ingredient, such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, etc. or compounds, such as an oxide containing alkaline earth metal ingredients, such as BeO, CaO, SrO, and BaO, etc., or silicon compounds, such as SiO₂, etc., can be used suitably.

In the case of glass ceramics, compounds, such as an oxide containing a rare-earth-elements ingredient, such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, etc., or compounds, such as an oxide containing alkaline earth metal ingredients, such as BeO, CaO, SrO, and BaO, etc., or silicon compounds, such as SiO₂, etc., can be used suitably.

and so on.

In this invention, the optical transmissivity of the above-mentioned various sintered compacts which comprise a ceramic material as the main ingredients is a thing to the light of the range of 200 nm-800 nm wavelength at least.

The above-mentioned optical transmissivity is measured with light of wavelength 605 nm.

In this invention, unless reference is made especially, the above-mentioned measured value was used for the optical transmissivity of the various sintered compacts which comprise a ceramic material as the main ingredients from now on.

Such various sintered compacts which comprise a ceramic material as the main ingredients and have optical permeability is made into a substrate, and if the thing on which the thin film which comprises as the main ingredients at least one or more materials selected from a gallium nitride, an indium nitride, and an aluminum nitride and has various crystallized states, such as a single crystal, an amorphous state, a polycrystal, and an orientated polycrystal etc., was formed beforehand on this substrate is used as a substrate, since the single crystal thin film which comprises as the main ingredients at least one or more materials selected from a gallium nitride, an indium nitride, and an aluminum nitride can be formed on it, by using such substrate on which the single crystal thin film is formed, a light emitting device is producible by forming a thin film anew on it, or a light emitting device is also producible using the single crystal thin film formed by doing in this way as at least a part of thin film layer which constitutes a light emitting device as it is.

In this invention, in the case of a light emitting device produced using as a substrate what has optical permeability among the above-mentioned sintered compacts which comprise as the main ingredients each zirconium oxide, magnesium oxide, magnesium aluminate, titanium oxide, barium titanate, lead titanate zirconate, rare-earth oxides for example a yttrium oxide, thorium dioxide, various ferrites, mullite, forsterite, steatite, and glass ceramics etc., since what excels in luminous efficiency is easy to be obtained, what is at least equivalent or what has been improved to a maximum of not less than 2-3 times have been able to produce if it is compared with the luminous efficiency of the light emitting device produced using the conventional sapphire substrate.

In this invention, unless reference is made especially, optical transmissivity of the above-mentioned various sintered compacts which comprise as the main ingredients a ceramic material, such as a zirconium oxide, a magnesium oxide, a magnesium aluminate, a titanium oxide, a barium titanate, a lead titanate zirconate, rare-earth oxides for example a yttrium oxide, a thorium dioxide, various ferrites, a mullite, a forsterite, a steatite, and glass ceramics etc., expresses the ratio of the intensity of an incident light and the intensity of a transmitted light which were measured with the spectrophotometer etc. by percentage by applying the light of predetermined wavelength to the above-mentioned sintered compact sample by using the disc-like sample which has 25.4 mm diameter and 0.5 mm thickness and which is the state of having ground the surface to the specular plane as well as the sintered compact which comprises an aluminum nitride as the main ingredients.

Unless reference is made especially, as wavelength, usually it is measured using 605 nm.

By setting the above-mentioned test sample to the inside of an integrating sphere, and by collecting all transmitted light, the optical transmissivity in this invention is what calculated as total transmittance which expressed the intensity ratio of this all transmitted light and incident light with percentage.

In addition, as for the performance of various sintered compacts according to this invention which comprise as the main ingredients a ceramic material, such as a zirconium oxide, a magnesium oxide, a magnesium aluminate, a titanium oxide, a barium titanate, a lead titanate zirconate, rare-earth oxides for example a yttrium oxide, a thorium dioxide, various ferrites, a mullite, a forsterite, a steatite, and glass ceramics, etc., even if the optical transmissivity has not measured using the light other than the wavelength of 605 nm, if the optical transmissivity to the light with a wavelength 605 nm is grasped, the luminous efficiency of the produced light emitting device when used as a substrate for light emitting device production can be judged, for example.

Optical transmissivity changes with the thickness of a sample, in the above-mentioned various sintered compacts according to this invention which comprise as the main ingredients a ceramic material, such as a zirconium oxide, a magnesium oxide, a magnesium aluminate, a titanium oxide, a barium titanate, a lead titanate zirconate, rare-earth oxides for example a yttrium oxide, a thorium dioxide, various ferrites, a mullite, a forsterite, a steatite, and glass ceramics, etc., when it is actually used as a substrate for thin film formation, a thin film substrate, or a substrate for light emitting device production, it is effective to make thickness of this substrate thin and to raise optical transmissivity, in order to raise the luminous efficiency of a light emitting device, for example.

Usually, it is desirable to use what has the thickness not less than 0.01 mm as a substrate for thin film formation, a thin film substrate, or a substrate for light emitting device production from a point of handling strength.

Since optical transmissivity will tend to decrease if thickness becomes thick, it is usually preferred to use what has the thickness not more than 8.0 mm as the substrate for thin film formation, a thin film substrate, or a substrate for light emitting device production.

In this invention, as for what has the thickness of the above-mentioned various sintered compacts which comprise as the main ingredients a ceramic material, such as a zirconium oxide, a magnesium oxide, a magnesium aluminate, a titanium oxide, a barium titanate, a lead titanate zirconate, rare-earth oxides for example a yttrium oxide, a thorium dioxide, various ferrites, a mullite, a forsterite, a steatite, and glass ceramics, etc. in the range of at least 0.01 mm-8.0 mm, it is effective if the substrate for thin film formation, a thin film substrate, or the substrates for light emitting device production etc. have optical permeability in the condition of actually being used.

That is, as the thickness of the above-mentioned various sintered compacts which comprise as the main ingredients a ceramic material, such as a zirconium oxide, a magnesium oxide, a magnesium aluminate, a titanium oxide, a barium titanate, a lead titanate zirconate, rare-earth oxides for example a yttrium oxide, a thorium dioxide, various ferrites, a mullite, a forsterite, a steatite, and glass ceramics, etc., even if it is the range of at least 0.01 mm-8.0 mm or except it, the optical transmissivity in the state where it is actually used should just be at least 1% or more, for example, even if the thickness is not actually 0.5 mm necessarily as a substrate for light emitting device production, such as 0.1 mm or 2.0 mm etc., if it has optical permeability, for example, if the optical transmissivity is at least not less than 1% the luminous efficiency of the light emitting device produced tends to improve.

Therefore, as for the optical transmissivity of the above-mentioned various sintered compacts which comprise as the main ingredients a ceramic material, such as a zirconium oxide, a magnesium oxide, a magnesium aluminate, a titanium oxide, a barium titanate, a lead titanate zirconate, rare-earth oxides for example a yttrium oxide, a thorium dioxide, various ferrites, a mullite, a forsterite, a steatite, and glass ceramics, etc. it is unrelated to the thickness of this sintered compact, and the optical permeability in the condition that this sintered compact is actually used is important, and it means the optical transmissivity in the condition that this sintered compact is actually used.

When the thickness of various sintered compacts which comprise as the main ingredients a ceramic material, such as a zirconium oxide, a magnesium oxide, a magnesium aluminate, a titanium oxide, a barium titanate, a lead titanate zirconate, rare-earth oxides for example a yttrium oxide, a thorium dioxide, various ferrites, a mullite, a forsterite, a steatite, and glass ceramics, etc. is thinner than 0.5 mm at a real busy condition, or when thicker than 0.5 mm, it differs from the optical transmissivity measured at the time of the substrate thickness of 0.5 mm, when thinner than 0.5 mm, optical transmissivity tends to become higher than the optical transmissivity measured at the time of 0.5 mm, and when thicker than 0.5 mm, it tends to become lower than the optical transmissivity measured at the time of 0.5 mm.

In this invention, as mentioned above, it is preferred to use the various sintered compacts in which the optical transmissivity is not less than 1% in the condition of actually being used and which comprise as the main ingredients a ceramic material, such as a zirconium oxide, a magnesium oxide, a magnesium aluminate, a titanium oxide, a barium titanate, a lead titanate zirconate, rare-earth oxides for example a yttrium oxide, a thorium dioxide, various ferrites, a mullite, a forsterite, a steatite, and glass ceramics, etc.

In this invention, the thin film substrate in which the optical waveguide by the thin film which comprises as the main ingredients at least one or more materials selected from a gallium nitride, an indium nitride, and an aluminum nitride was formed on the sintered compact which comprises an aluminum nitride as the main ingredients can be provided.

A thin film substrate which can respond to the optical transmission of a broad wavelength area from an ultraviolet-rays area to an infrared area, such as the range of wavelength 200 nm-7000 nm, can be provided using a thin film substrate according to this invention in which an optical waveguide was formed.

It became possible to transmit the ultraviolet light of the range of 200 nm-380 nm especially, without being accompanied by big loss.

If the thin film which is used for an optical waveguide and which comprises as the main ingredients at least one or more materials selected from a gallium nitride, an indium nitride, and an aluminum nitride is a single crystal, transmission loss of light can be reduced more.

This optical transmission nature is realizable by having an excellent optical permeability of the thin film which comprises as the main ingredients at least one or more materials selected from a gallium nitride, an indium nitride, and an aluminum nitride.

Transmission of ultraviolet light with short wavelength, especially the range of 200 nm-380 nm, is realizable by using a thin film with many contents of an aluminum nitride.

Such optical transmission nature also results from that whose thin film which is used as an optical waveguide and which comprises as the main ingredients at least one or more materials selected from a gallium nitride, an indium nitride, and an aluminum nitride can form as a single crystal on the sintered compact which comprises an aluminum nitride as the main ingredients.

Moreover, such optical transmission nature also results from good junction nature between the sintered compact which comprises an aluminum nitride as the main ingredients and the thin film which comprises as the main ingredients at least one or more materials selected from a gallium nitride, an indium nitride, and an aluminum nitride used as an optical waveguide.

As mentioned above, as for junction nature between the sintered compact which comprises an aluminum nitride as the main ingredients and the thin film which comprises as the main ingredients at least one or more materials selected from a gallium nitride, an indium nitride, and an aluminum nitride, a crack is not looked at in the thin film after joining, and exfoliation is not looked at at the junction interface, even if a tearing test is performed by using adhesive tape, exfoliation at a junction interface does not arise.

It is because the single crystal thin film which comprises as the main ingredients at least one or more materials selected from a gallium nitride, an indium nitride, and an aluminum nitride can be formed on the sintered compact which comprises an aluminum nitride as the main ingredients in this invention.

This invention is the thin film substrate in which the optical waveguide was formed by the thin film which comprises as the main ingredients at least one or more materials selected from a gallium nitride, an indium nitride, and an aluminum nitride, since the sintered compact which comprises an aluminum nitride as the main ingredients is used for the material which constitutes a substrate and it excels in a nature of radiating heat, when high-output light emitting devices, such as a semiconductor laser, are mounted, it is preferred.

Since not only the above-mentioned optical waveguide but also an electrical circuit can be formed in the inside and/or surface at this sintered compact which comprises an aluminum nitride as the main ingredients, there is the feature that it can use as an optical wiring substrate which has the above-mentioned optical waveguide and an electrical circuit.

That is, as for the thin film substrate which can transmit the light from blue and ultraviolet light emitting devices, such as the semiconductor laser diode or light emitting diode which comprise as the main ingredients at least one or more materials selected from a gallium nitride, an indium nitride, and an aluminum nitride, it is predicted that the application will spread greatly according to this invention from now on, and it can be provided.

This invention has the feature that the thin film substrate which mounts the above-mentioned blue and an ultraviolet light emitting device directly, and functions as an optical wiring substrate can be provided.

What has at least one of the crystallized states which were selected from a single crystal, an amorphous state, a polycrystal, and an orientated polycrystal as an optical waveguide by the thin film which comprises as the main ingredients at least one or more materials selected from a gallium nitride, an indium nitride, and an aluminum nitride and was formed on the sintered compact which comprises an aluminum nitride as the main ingredients can be used.

When light with 650 nm wavelength is transmitted by using the thin film of such crystallized state, optical waveguide of which transmission loss is not more than 10 dB/cm can usually form at least.

It becomes possible to achieve reduction of transmission loss by using a single crystal thin film in it, it usually becomes possible to form the optical waveguide of not more than 5 dB/cm at least.

In the thing whose half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride is not more than 100 seconds, it becomes possible to form the optical waveguide of not more than 3 dB/cm at least.

The wavelength of the light which can be transmitted using the optical waveguide according to this invention depends on the composition of a thin film which comprises as the main ingredients at least one or more materials selected from a gallium nitride, an indium nitride, and an aluminum nitride.

It is preferred to use the thin film which comprises as the main ingredients at least one or more materials selected from a gallium nitride and an aluminum nitride to the ultraviolet light of the range of wavelength 200 nm-380 nm and light with a wavelength not less than 380 nm as an optical waveguide.

When ultraviolet light with more short wavelength is transmited, it is preferred to use the thin film of composition with only an aluminum nitride or with many contents of an aluminum nitride.

Ultraviolet light with short wavelength can be transmitted with lower loss by using the thin film of such composition.

To visible light with a wavelength of 380 nm-650 nm, besides the thin film of the above-mentioned composition, the thin film which comprises as the main ingredients at least one or more materials selected from a gallium nitride, an indium nitride, and an aluminum nitride can be used as an optical waveguide.

When visible light with more short wavelength is transmitted, it is preferred to use the thin film of composition with only an aluminum nitride or with many contents of an aluminum nitride or the thin film of composition with only a gallium nitride or with many contents of a gallium nitride.

Visible light with short wavelength can be transmitted with lower loss by using the thin film of such composition.

To the light with a wavelength not less than 650 nm at least, the thin film of composition of all the combination of a gallium nitride, an indium nitride, and an aluminum nitride can be used as an optical waveguide.

In this invention, it is preferred to use the thin film which comprises as the main ingredients at least one or more materials selected from a gallium nitride and an aluminum nitride as mentioned above as an optical waveguide for transmitting ultraviolet light.

Speaking more concretely, it is preferred to use the thin film which comprises as the main ingredients the composite which is expressed by the chemical formula of AlₓGa₁₋ₓN (0.0≦x≦1.0) as an optical waveguide for transmitting ultraviolet light.

It becomes possible to transmit up to ultraviolet rays of 200 nm wavelength by using these materials as an optical waveguide.

The optical waveguide which was formed by the above-mentioned thin film which comprises as the main ingredients at least one or more materials selected from a gallium nitride and an aluminum nitride can transmit not only ultraviolet light but also visible light of a wavelength not less than 380 nm and infrared light of a wavelength not less than 800 nm in low loss.

In order to lessen transmission loss of ultraviolet light of shorter wavelength, it is more preferred to use the thin film containing many aluminum nitride ingredients as an optical waveguide.

That is, when transmitting light with a wavelength not more than 380 nm, it is preferred to use the thin film which has composition of the range of 0.0≦x≦1.0 in the above-mentioned chemical formula, when the light of the wavelength 380 nm is used, the optical waveguide whose transmission loss is not more than 10 dB/cm can be formed.

The optical waveguide whose transmission loss is not more than 5 dB/cm can be formed by using a single crystal as a thin film of the above-mentioned composition range.

In the thing whose half width of the rocking curve of the X-ray diffraction line from the lattice plane of the Miller Index (002) of this single crystal thin film is not more than 100 seconds, it becomes possible to form the optical waveguide of at least not more than 3 dB/cm.

When transmitting the light with a wavelength not more than 300 nm, it is preferred to use the thin film which has composition of the range of 0.5≦x≦1.0, when the light of the wavelength 300 nm is used, the optical waveguide whose transmission loss is not more than 10 dB/cm can be formed.

The optical waveguide whose transmission loss is not more than 5 dB/cm can be formed by using a single crystal as a thin film of the above-mentioned composition range.

In the thing whose half width of the rocking curve of the X-ray diffraction line from the lattice plane of the Miller Index (002) of this single crystal thin film is not more than 100 seconds, it becomes possible to form the optical waveguide of at least not more than 3 dB/cm.

When transmitting the light with a wavelength not more than 270 nm, it is preferred to use the thin film which has composition of the range of 0.8≦x≦1.0, when the light of the wavelength 270 nm is used, the optical waveguide whose transmission loss is not more than 10 dB/cm can be formed.

The optical waveguide whose transmission loss is not more than 5 dB/cm can be formed by using a single crystal as a thin film of the above-mentioned composition range.

In the thing whose half width of the rocking curve of the X-ray diffraction line from the lattice plane of the Miller Index (002) of this single crystal thin film is not more than 100 seconds, it becomes possible to form the optical waveguide of at least not more than 3 dB/cm.

When transmitting light with a wavelength not more than 250 nm, it is preferred to use the thin film which has composition of the range of 0.9≦x≦1.0, when the light with the wavelength 250 nm is used, the optical waveguide whose transmission loss is not more than 10 dB/cm can be formed.

The optical waveguide whose transmission loss is not more than 5 dB/cm can be formed by using a single crystal as a thin film of the above-mentioned composition range.

In the thing whose half width of the rocking curve of the X-ray diffraction line from the lattice plane of the Miller Index (002) of this single crystal thin film is not more than 100 seconds, it becomes possible to form the optical waveguide of at least not more than 3 dB/cm.

If the single crystal thin film which has composition of the above range of 0.8≦x≦1.0 is used, it will enable to obtain an embedded type of three dimension optical waveguide whose transmission loss of the light with a wavelength not less than 300 nm is not more than 1 dB/cm.

Since materials, such as LiNbO₃, LiTaO₃, PLZT, GaAs and PbMoO₄ which are hitherto used as an optical waveguide, do not penetrate ultraviolet light, they cannot perform transmission of ultraviolet light.

As a material which can penetrate and transmit ultraviolet light, many things, such as silica glass, alumina (sapphire), and calcium fluoride etc., are known.

However, when these materials is formed on the sintered compact which comprises an aluminum nitride as the main ingredients in the thickness not less than 0.5 μm as a thin film, since in these thin films distortion which is considered to originate in a lattice mismatching or a difference of thermal expansion coefficient is generated or crack occurs when extreme or exfoliation may arise in the junction interface of the sintered compact which comprises an aluminum nitride as the main ingredients and thin film materials, such as silica glass, alumina (sapphire), and calcium fluoride etc., it is unsuitable to transmit ultraviolet light substantially.

In this invention, since the thin film which comprises as the main ingredients at least one or more materials selected from a gallium nitride and an aluminum nitride is used to the sintered compact which comprises an aluminum nitride as the main ingredients, it is hard to produce such fault.

As mentioned above, according to this invention, the thin film substrate which has the optical waveguide which can transmit the ultraviolet light which was difficult in the optical waveguide using the conventional material, such as LiNbO₃ etc. can be provided.

In addition, as an optical waveguide there are what formed on the sapphire substrate or the silicon substrate the thin film which comprises as the main ingredients at least one or more materials selected from a gallium nitride and an aluminum nitride as a material which can be penetrated and transmitted ultraviolet light.

However, even if these thin films can be formed as a single crystal thin film of high crystallinity, it is easy to produce crystal dislocation and a strain in an optical waveguide by the mismatching of crystal lattice, or the difference of thermal expansion coefficient between the substrate and this thin film, as a result, transmission loss will tend to become more than 10 dB/cm easily.

Since a crack or exfoliation between a substrate is easy to be produced in aluminum nitride thin film formed on the silicon substrate, it is difficult to function as an optical waveguide, moreover, since electric insulation is small and the dielectric constant is high, when a silicon substrate is used, it is hard to form an electrical circuit directly on a substrate.

Since not only the above-mentioned optical waveguide but also an electrical circuit can be formed in the inside and/or on the surface of the above-mentioned sintered compact which comprises an aluminum nitride as the main ingredients and constitutes the thin film substrate according to this invention which has an optical waveguide which can transmit ultraviolet light, there is a feature in which the thin film substrate according to this invention can be used as an optical wiring substrate which can transmit the ultraviolet light and which has an optical waveguide and an electrical circuit.

In this invention, the thin film which comprises as the main ingredients at least one or more materials selected from a gallium nitride, an indium nitride, and an aluminum nitride directly formed on the sintered compact which comprises an aluminum nitride as the main ingredients as an optical waveguide can be used as an optical waveguide.

When the sintered compact which comprises an aluminum nitride as the main ingredients and which formed beforehand the thin film comprising at least one or more materials selected from a gallium nitride, an indium nitride, and an aluminum nitride as the main ingredients is used, the thin film which comprises as the main ingredients at least one or more materials selected from a gallium nitride, an indium nitride, and an aluminum nitride and is formed anew on it can also be used as an optical waveguide, and transmission loss may be able to be lowered if it is compared with what formed the thin film directly on the sintered compact which comprises an aluminum nitride as the main ingredients.

It is desirable that the index of refraction of the above mentioned thin film anew formed on the sintered compact which comprises an aluminum nitride as the main ingredients and which formed beforehand the thin film which comprises as the main ingredients at least one or more materials selected from a gallium nitride, an indium nitride, and an aluminum nitride is larger than the index of refraction of the thin film which is being formed beforehand on the sintered compact which comprises an aluminum nitride as the main ingredients in order to reduce transmission loss.

As mentioned above, except the reason for the ability to form a good thin film rather than forming on the sintered compact which comprises an aluminum nitride as the main ingredients directly, it is thought that it is based on the principle that the light which penetrates the inside of a material with a large index of refraction is shut up into a material with a large index of refraction, and, as a result, light is transmitted, when a material with a large index of refraction is formed in a material with a small index of refraction.

The thickness of the above-mentioned thin film formed beforehand can use anything, for example, what is the range of 0.5 nm-1000 μm can be used suitably.

Usually, an optical waveguide with less transmission loss is producible by using what is the thickness not less than 50 nm.

The thickness of the thin film with a large index of refraction which functions as an optical waveguide anew formed on the thin film formed beforehand should just usually be what is the range of 0.1 μm-1000 μm.

When a thin film with a large index of refraction is operated as an optical waveguide combining a thin film with a small index of refraction, and a thin film with a large index of refraction, if there are not less than 0.1 μm of thickness of this optical waveguide, it may function enough.

In this invention, all the combination of a thin film with a small index of refraction and a thin film with a large index of refraction used as an optical waveguide is possible.

That is, in all composition of the thin film which comprises as the main ingredients at least one or more materials selected from a gallium nitride, an indium nitride, and an aluminum nitride, or in all crystallized states, such as a single crystal, an amorphous state, a polycrystal, and an orientated polycrystal, the above-mentioned combination is possible.

The thin film with this small index of refraction may bear a role of a cladding layer in the optical waveguide usually used hitherto.

In this invention, as mentioned above, as for the thin film with an index of refraction small, not only what is formed between the sintered compact which comprises an aluminum nitride as the main ingredients, and the thin film with a large index of refraction used as an optical waveguide but also what is formed on the thin film with a large index of refraction used as an optical waveguide formed on the sintered compact which comprises an aluminum nitride as the main ingredients can use, even if a thin film with a small index of refraction is in the above formation conditions, a role of a cladding layer in the optical waveguide usually used hitherto may be borne.

If a concrete example about the thin film substrate which is formed by combining a thin film with a small index of refraction and a thin film with the large index of refraction used as an optical waveguide is shown, 1) there are what combined the thin film which comprises as the main ingredients at least one or more materials selected from a gallium nitride, an indium nitride, and an aluminum nitride, and the thin film which contains more at least one or more ingredients selected from gallium and indium which comprises as the main ingredients at least one or more materials selected from a gallium nitride, an indium nitride, and an aluminum nitride.

Moreover, 2) there are examples, such as what combined the thin film which comprises as the main ingredients at least one or more materials selected from a gallium nitride, an indium nitride, and an aluminum nitride and the thin film which comprises as the main ingredients at least one or more materials selected from a gallium nitride, an indium nitride, and an aluminum nitride and contains furthermore at least one or more elements selected from niobium and tantalum.

The background of the above-mentioned example having been shown is based on the knowledge of two points having been acquired below.

That is, 1) it was checked that the index of refraction of a thin film rises as many at least one or more ingredients selected from gallium and indium were contained in the thin film which comprises as the main ingredients at least one or more materials selected from a gallium nitride, an indium nitride, and an aluminum nitride and was formed on the sintered compact which comprises an aluminum nitride as the main ingredients.

Saying concretely, to the original thin film which comprises as the main ingredients at least one or more materials selected from a gallium nitride, an indium nitride, and an aluminum nitride, if increment of at least one or more ingredients selected from a gallium nitride and an indium nitride is not more than 20 mol % to the main ingredients, the rise of an index of refraction is not more than 2×10⁻¹.

to the original thin film which comprises as the main ingredients at least one or more materials selected from a gallium nitride, an indium nitride, and an aluminum nitride, even if increment of at least one or more ingredients selected from a gallium nitride and an indium nitride is about 0.01 mol % to the main ingredients, the rise of an index of refraction is observed at least not less than 1×10⁻⁵.

2) in the case of the thin film which comprises as the main ingredients at least one or more materials selected from a gallium nitride, an indium nitride, and an aluminum nitride and contains further at least one or more ingredients selected from niobium or tantalum, it was found out that the index of refraction has risen if it is compared with the thin film which comprises as the main ingredients at least one or more materials selected from a gallium nitride, an indium nitride, and an aluminum nitride which do not contain niobium or tantalum.

Saying concretely, in the thin film which comprises as the main ingredients at least one or more materials selected from a gallium nitride, an indium nitride, and an aluminum nitride, if the content of at least one or more ingredients selected from niobium and tantalum is not more than 20 mol % by nitride conversion to the main ingredients, the rise of an index of refraction is not more than 2×10⁻¹.

In the thin film which comprises as the main ingredients at least one or more materials selected from a gallium nitride, an indium nitride, and an aluminum nitride, even if the content of at least one or more ingredients selected from niobium and tantalum is about 0.01 mol % by nitride conversion to the main ingredients, the rise of a refractive index at least not less than 1×10⁻⁵ is observed.

As the effect of niobium or tantalum being included, this inventor is surmising that it is the cause of main that it probably has the property in which niobium or tantalum tends to dissolve in a gallium nitride, or an indium nitride, or an aluminum nitride, or a compound which has two or more these ingredients.

Namely, it is guessed that niobium or tantalum should dissolve in the crystal of a gallium nitride, or an indium nitride, or an aluminum nitride, or a compound which has two or more these ingredients.

Niobium nitride or tantalum nitride is considered that dissolution is easy to realize since it has the crystal structure of the same hexagonal system as a gallium nitride, or an indium nitride, or an aluminum nitride, or a compound which has two or more these ingredients.

It is not only physically mixed as a different material, it is surmised that the rise of an index of refraction is attained since what is the same crystal structure has dissolved together on the atomic level inside the crystal even if it is a different ingredient.

In this invention, the above-mentioned thin film which comprises as the main ingredients at least one or more materials selected from a gallium nitride, an indium nitride, and an aluminum nitride and contains further at least one or more ingredients selected from niobium or tantalum can be used also as an optical waveguide which transmits the light of the range of 200 nm-7000 nm wavelength at least, since it can transmit not only visible light and infrared light but also the light of the ultraviolet of the range of 200 nm-380 nm wavelength can be transmitted.

As for the thin film which comprises as the main ingredients at least one or more materials selected from a gallium nitride, an indium nitride, and an aluminum nitride, it can obtain what contains the ingredient of only a niobium or only a tantalum or both of niobium and tantalum simultaneously.

As for the content of at least one or more ingredients selected from niobium and tantalum in the thin film which comprises as the main ingredients at least one or more materials selected from a gallium nitride, an indium nitride, and an aluminum nitride, it is preferred that it is less than 20 mol % by nitride conversion to the main ingredients.

That is, it is considered that a niobium ingredient and a tantalum ingredient exist as niobium nitride (NbN) and tantalum nitride (TaN) in a thin film, respectively, if the content of a main ingredient is expressed with the formula of m (AlxGayIn1-x−yN:0.0≦x≦1.0, 0.0≦y≦1.0, and 0.0≦x+y≦1.0), the content of the niobium ingredient to contain or a tantalum ingredient is shown by the formula (1-m) (NbuTal-uN), as for the content of niobium in a thin film, and the content of tantalum, it is preferred that it is the range of 0.8≦m≦1.0 and 0.0≦u≦1.0.

Because transmission loss is easy to become increase, when this thin film is used as an optical waveguide if there are more contents of at least one or more ingredients selected from the niobium and tantalum in a thin film than 20 mol % by nitride conversion.

As for the effect of containing niobium and tantalum in the thin film which comprises as the main ingredients at least one or more materials selected from a gallium nitride, an indium nitride, and an aluminum nitride, even if it is about 0.01 mol % quantity by nitride conversion to the main ingredients, the refractive index of the main ingredients rises by at least not less than 1×10⁻⁵, and this thin film may be made to function as an optical waveguide.

Measurement of the index of refraction of a thin film can be easily performed using optical apparatus, such as polarization analysis using the usual ellipsometer etc., a repetition interference microscope method, a prism coupler method, or other spectrophotometers (Spectrophotometer).

The accuracy of measurement of such an index of refraction is possible to the digit of 1×10⁻⁵, and can be measured in the accuracy of at least 2×10⁻⁵.

As mentioned above, in this invention, not only the thin film which comprises as the main ingredients at least one or more materials selected from a gallium nitride, an indium nitride, and an aluminum nitride but also the thin film which contains at least one or more ingredients selected from niobium or tantalum in the thin film which comprises as the main ingredients at least one or more materials selected from a gallium nitride, an indium nitride, and an aluminum nitride can be used as an optical waveguide.

As for the above-mentioned thin film which contains at least one or more ingredients selected from niobium or tantalum in the thin film which comprises as the main ingredients at least one or more materials selected from a gallium nitride, an indium nitride, and an aluminum nitride, it can use not only as the optical waveguide which was combined with the thin film with an index of refraction smaller than this thin film but also as an optical waveguide alone, such as directly forming on the sintered compact which comprises an aluminum nitride as the main ingredients, for example.

In this invention, as the above thin film substrate in which the thin film with the large index of refraction which becomes a thin film with a small index of refraction with an optical waveguide was formed, or as the thin film substrate which formed the thin film with a small index of refraction in the thin film with the large index of refraction used as an optical waveguide, what was laminated one by one in the thin film with a small index of refraction by the thin film with a large index of refraction or the thin film with a large index of refraction can be used for a thin film with a small index of refraction by conventional methods, such as the above-mentioned CVD, MOCVD, MBE, and Sputtering.

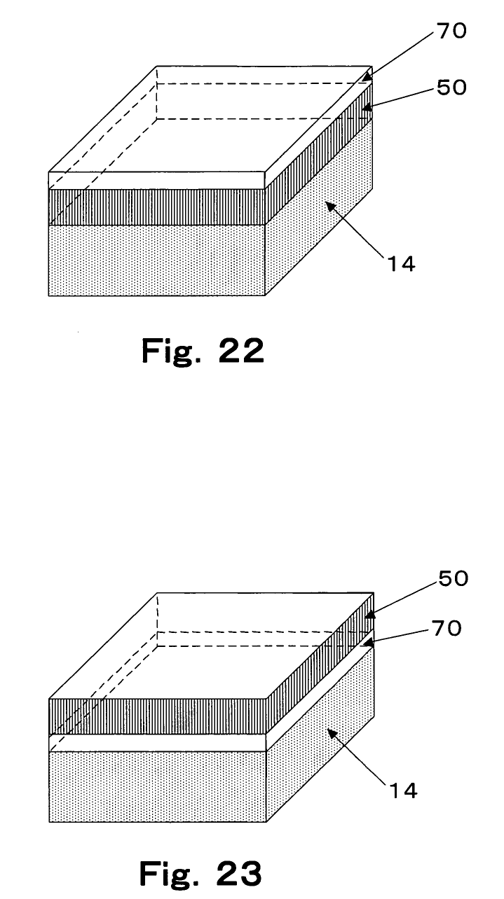

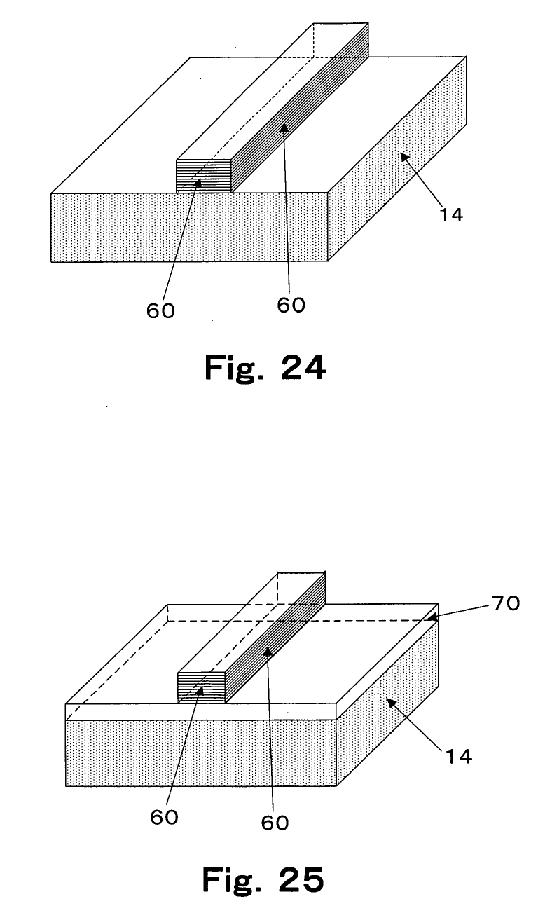

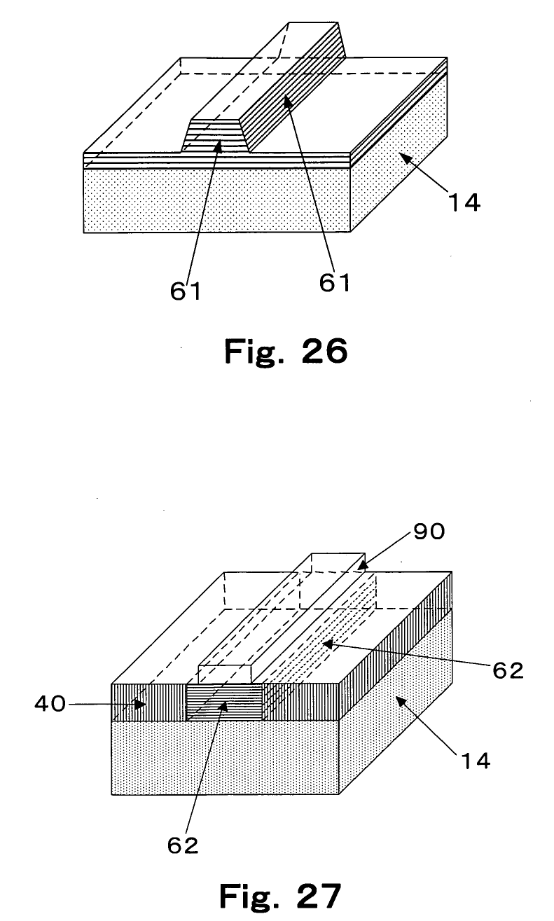

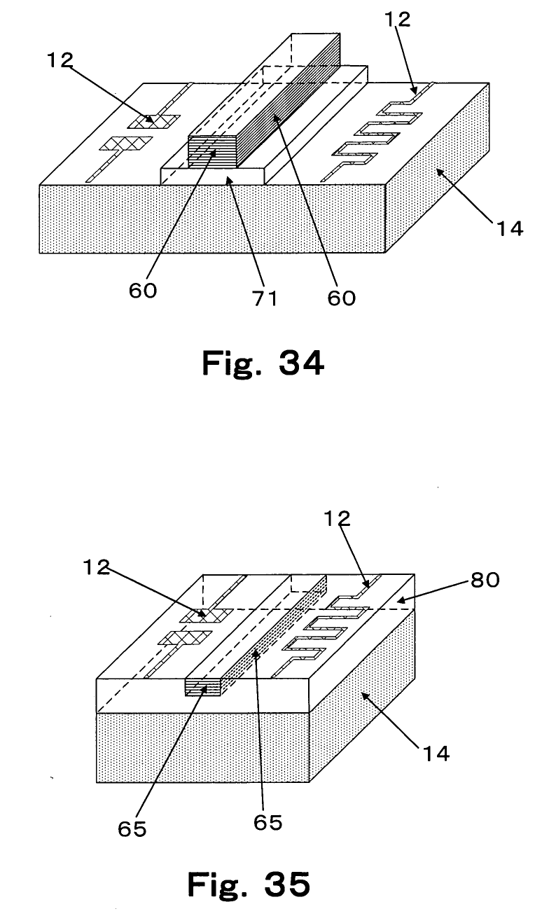

The optical waveguide illustrated by such method in FIG. 21, FIG. 22, FIG. 23, FIG. 24, FIG. 25, FIG. 26, and FIG. 34 is producible.

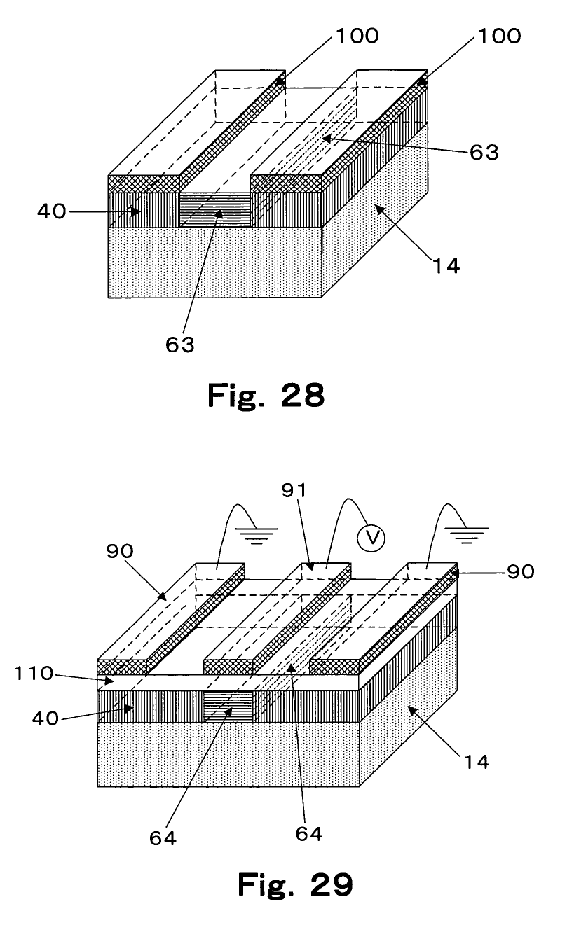

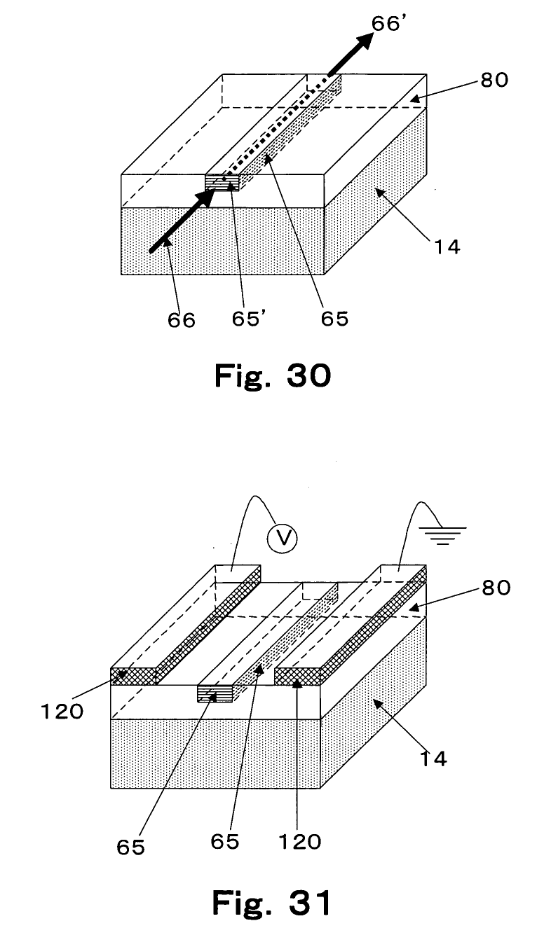

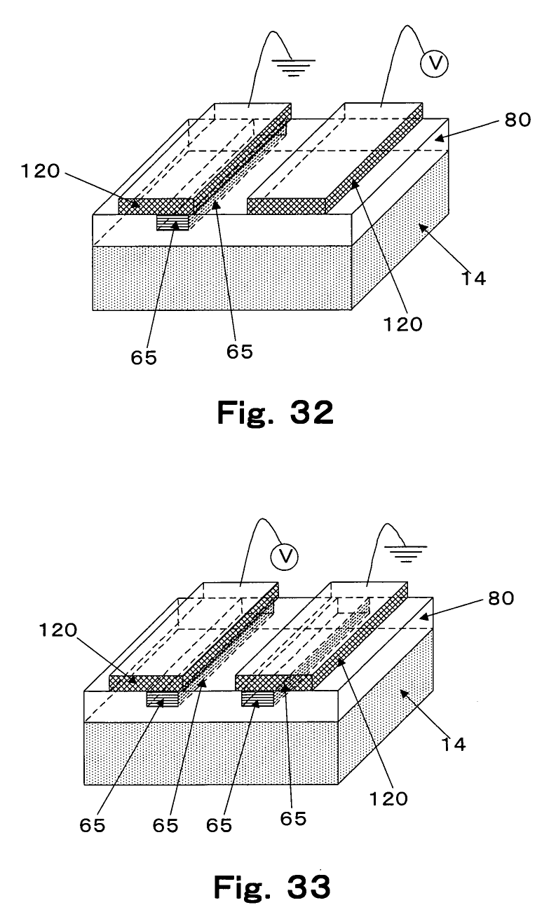

The slot and the hollow are formed into the thin film with a small index of refraction, the method of embedding a thin film with a large index of refraction one by one can also be used, and the optical waveguide illustrated by such method in FIG. 27, FIG. 28, FIG. 29, FIG. 30, FIG. 31, FIG. 32, FIG. 33, and FIG. 35 can be produced.

As the above-mentioned thin film substrate on which the thin film with the large index of refraction which becomes an optical waveguide was formed in a thin film with small index of refraction, besides that a thin film is formed one by one by laminating method as mentioned above, it can form also by the method of raising the index of refraction of the thin film portion in which at least one or more ingredients selected from this gallium, indium, niobium, and tantalum are contained by making at least one or more ingredients selected from gallium, indium, niobium, and tantalum, for example, contain especially in the depth direction of the thin film which comprises as the main ingredients at least one or more materials selected from a gallium nitride, an indium nitride, and an aluminum nitride, by using a thermal diffusion method or ion implantation method, for example.

As a thermal diffusion method, there is method, for example, this gallium, indium, niobium, and a tantalum ingredient are diffused in the thin film which comprises as the main ingredients at least one or more materials selected from a gallium nitride, an indium nitride, and an aluminum nitride, by heat-treating at high temperature not less than 800 degrees C if it requires in non-oxidizing atmospheres, such as nitrogen, after the material containing gallium ingredients, such as a gallium nitride, metal gallium, and gallium oxide, or indium ingredients, such as an indium nitride, metal indium, and indium oxide, or niobium ingredients, such as niobium nitride, metal niobium, and niobium oxide, or tantalum ingredients, such as tantalum nitride, metal tantalum, and tantalum oxide, is newly formed in the thin film which comprises as the main ingredients at least one or more materials selected from a gallium nitride, an indium nitride, and an aluminum nitride which is formed on the sintered compact which comprises an aluminum nitride as the main ingredients, etc.

Consequently, a portion with more contents of gallium or indium than the original thin film which comprises as the main ingredients at least one or more materials selected from a gallium nitride, an indium nitride, and an aluminum nitride is formed in the depth direction and width direction of a thin film, and an index of refraction rises, and it comes to function as an optical waveguide.

The thin film which comprises as the main ingredients at least one or more materials selected from a gallium nitride, an indium nitride, and an aluminum nitride which newly contain niobium or a tantalum ingredient is formed, an index of refraction rises, and it comes to function as an optical waveguide.

According to the above-mentioned thermal diffusion method, although it is dependent also on heating temperature or heat time, since the rise of an index of refraction is not more than 2×10⁻¹ and is usually in the range of 1×10⁻⁵ to 2×10⁻¹, to the original thin film which comprises as the main ingredients at least one or more materials selected from a gallium nitride, an indium nitride, and an aluminum nitride, it is guessed that the increment of at least one or more ingredients selected from a gallium nitride and an indium nitride is less than 20 mol % to the main ingredients.

Even if the increment of the above-mentioned ingredient of a gallium nitride or an indium nitride is less than 1 mol % to the main ingredients, the rise of an index of refraction usually has the range of 1×10⁻⁵ -1×10⁻², and it functions as an optical waveguide enough.

Furthermore, by the above-mentioned thermal diffusion method, although it is dependent also on heating temperature or heat time, since the index of refraction of the thin film which comprises as the main ingredients at least one or more materials selected from a gallium nitride, an indium nitride, and an aluminum nitride containing at least one or more elements selected from niobium and tantalum is not more than 2×10⁻¹ and is usually in the range of 1×10⁻⁵ to 2×10⁻¹, it seems that the content of at least one or more ingredients selected from niobium and tantalum is not more than 20 mol % to the main ingredients.

As for the content of niobium or tantalum, it is preferred that it is not more than 10 mol % to the main ingredients in order to lower the transmission loss.

Even if the above-mentioned content of niobium or tantalum is less than 1 mol % to the main ingredients, the rise of a refractive index is usually in the range of 1×10⁻⁵-1×10⁻², and it functions as an optical waveguide enough.

As ion implantation method, there is a method, for example, gallium ingredients, such as a gallium chloride, a gallium bromide, and gallium hydride, or indium ingredients, such as or an indium chloride, an indium bromide, and indium hydride, or niobium ingredients, such as niobium chloride, niobium bromide, and niobium hydride, or tantalum ingredients, such as tantalum chloride, tantalum bromide, and tantalum hydride, is used as an ionization source, the above-mentioned ingredient is ionized by using electric discharge etc., after removing unnecessary ion with mass spectrograph etc., gallium, indium, niobium, and tantalum ion are accelerated with the accelerator, then they are implanted to the thin film which comprises as the main ingredients at least one or more materials selected from a gallium nitride, an indium nitride, and an aluminum nitride, such that the ion implanted after that becomes uniform, it will heat-treat at the temperature not less than 500 degrees C if it requires in non-oxidizing atmospheres, for example, such as nitrogen, then the portion in which many gallium or indium is contained and the portion which newly contains niobium or tantalum in this thin film is formed, etc.

Consequently, a portion with more contents of gallium or indium than the original thin film which comprises as the main ingredients at least one or more materials selected from a gallium nitride, an indium nitride, and an aluminum nitride is formed in the depth direction and width direction of a thin film, and an index of refraction rises, and it comes to function as an optical waveguide.

The thin film which comprises as the main ingredients at least one or more materials selected from a gallium nitride, an indium nitride, and an aluminum nitride which newly contain niobium or a tantalum ingredient is formed, an index of refraction rises, and it comes to function as an optical waveguide.

When an optical waveguide is formed with the above-mentioned thermal diffusion method or ion implantation method, since, as for the original thin film which comprises as the main ingredients at least one or more materials selected from a gallium nitride, an indium nitride, and an aluminum nitride and was formed on the sintered compact which comprises an aluminum nitride as the main ingredients, an index of refraction becomes small, this thin film functions inevitably as a cladding layer for shutting up the light which is transmitted by an optical waveguide.

Since a thermal diffusion method or ion implantation method can form a fine optical waveguide by using the processing methods, such as optical lithography, when forming the embedded type optical waveguide which is used widely hitherto, it is effective.

In this invention, as an example of an embedded type optical waveguide, FIG. 30, FIG. 31, FIG. 32, FIG. 33, and FIG. 35 are illustrated, as below-mentioned.

In this above-mentioned invention, when forming an optical waveguide with a thermal diffusion method or ion implantation method the size of the portion into which the ingredient which raises an index of refraction is introduced can produce what is arbitrary, but if there are usually not less than 0.5 μm as width in the case of an above-mentioned embedded type optical waveguide, it will function as an optical waveguide enough.

Usually, as for the width of an optical waveguide, what is not less than 1 μm is formed.

Usually, as for the width of an optical waveguide, what is the range of 1 μm-500 μm is used.

Although the diffusion depth or the impregnation depth can produce arbitrary things, if there are not less than 0.1 μm, it may function as an optical waveguide with small enough transmission loss.

If there are the diffusion depth or the impregnation depth is not less than 0.3 μm, it may function as a smaller optical waveguide of transmission loss.

Usually, as for the diffusion depth or the impregnation depth, what is not less than 0.5 μm is used.

When an optical waveguide is formed with the above-mentioned thermal diffusion method or ion implantation method, although, as for the portion by which the ingredient which raises an index of refraction was formed beforehand on the thin film especially in the thermal diffusion method, the width of the portion in which this improvement ingredient of an index of refraction was introduced after thermal diffusion tends to spread if it compares before performing thermal diffusion, even if it is in such condition, it may function as an optical waveguide satisfactory.

When using the usual optical means in the refractometry of a thin film with thin width like the above-mentioned optical waveguide, since the light beam which is irradiated to a measured portion is narrowed down with an optical lens etc. the accuracy of an index of refraction tends to lower to the digit which is about 1×10⁻¹ to 1×10⁻², by not measuring directly in a portion with such thin width, but measuring the index of refraction of this thin film which is formed in another portion in the shape of a large field in order to become the same composition by the same method, it is regarded as the index of refraction of a thin film with thin width in many cases.

Although what is not less than 500 μm is usually used as the diameter of the light beam which is irradiated to a measured portion, it is possible to measure an index of refraction by irradiating such light beam which is narrowed down to the about wavelength of light, for example, 650 nm, at the minimum using an optical lens etc., for example, to the thin film portion which has a width 650 nm or more, as a result, the accuracy of measurement of an index of refraction tends to lower greatly from the original digit of 1×10⁻⁵ to about 1×10⁻¹ to 1×10⁻² digit.

Speaking more concretely, for example, when forming a fine thin film with a width of 10 μm as an optical waveguide by using the above-mentioned sequential laminating method, the diffusion method, or the ion implantation method, the index of refraction of the thin film of the portion which forms this optical waveguide is not measured directly, the index of refraction of the thin film formed in another portion in the large area (for example, 0.5 mm×2 or more mm) so that it might become the same composition is measured, so it is regarded as the index of refraction of an optical waveguide with a width of 10 μm with the index of refraction of this thin film.

In this invention, the index of refraction of the optical waveguide which comprised a thin film with thin width also was measured by such method.

In this invention, the increment of the index of refraction of the material which comprises as the main ingredients at least one or more materials selected from a gallium nitride, an indium nitride, and an aluminum nitride which contain niobium and tantalum and the optical transmission nature as an optical waveguide were confirmed also except the above-mentioned thin film.

That is, when niobium and tantalum are made to contain with a thermal diffusion method using each bulk-like single crystal which is the gallium nitride and aluminum nitride and which is not a thin film, the rise of a refractive index and the optical transmission nature are observed.

In the optical waveguide formed by making the bulk-like single crystal of a gallium nitride contain indium, niobium, and tantalum with the above-mentioned thermal diffusion method, an index of refraction rises more than at least 1×10⁻⁵ in a visible light area, and the optical waveguide in which light with a wavelength of more than at least 380 nm can transmit in the condition not more than 3 dB/cm as transmission losses can form in this bulk single crystal which comprises a gallium nitride as the main ingredients.

In the optical waveguide formed by making the bulk-like single crystal of an aluminum nitride contain gallium, indium, niobium, and tantalum with the above-mentioned thermal diffusion method, an index of refraction rises more than at least 1×10⁻⁵ in a visible light area, and the optical waveguide in which light with a wavelength of more than at least 250 nm can be transmitted in the condition not more than 3 dB/cm as transmission loss can form in this bulk single crystal which comprises a gallium nitride as the main ingredients.

Furthermore, the optical waveguide in which light with a wavelength of more than at least 220 nm can transmit in the condition not more than 10 dB/cm as transmission losses can form in this bulk single crystal which comprises a gallium nitride as the main ingredients.

In this invention, the thin film which comprises as the main ingredients at least one or more materials selected from a gallium nitride, an indium nitride, and an aluminum nitride which is directly formed on the sintered compact which comprises an aluminum nitride as the main ingredients can be used as an optical waveguide.

This has suggested that the index of refraction of a thin film is higher than the sintered compact which comprises an aluminum nitride as the main ingredients.

Although it seems that it is a big factor that the index of refraction of an aluminum nitride is the smallest originally in each ingredient of an a gallium nitride, an indium nitride, and an aluminum nitride, in addition, in the sintered compact of which the densification was carried out enough and which comprises an aluminum nitride as the main ingredients, it is thought that crystallization of the aluminum nitride particle which constitutes this sintered compact advances enough and it is in the condition near a single crystal, it is surmised that it will be because it becomes smaller than the index of refraction of a single crystal by impurities dissolution into an aluminum nitride particle, the grain boundary as a sintered compact, or the effect of a grain boundary phase.

Therefore, it seems that it becomes easy to produce a total reflection in it even if it is the thin film directly formed on the sintered compact which comprises an aluminum nitride as the main ingredients.

An aluminum nitride crystal is an optically anisotropic substance, of which a direction perpendicular to an optical axis, i.e., a crystal C axis, is the direction of ordinary light, and a direction parallel to C axis is the direction of extraordinary light, extraordinary light differs in an index of refraction from ordinary light, extraordinary light has large index of refraction of about 0.05 in a visible light area.

On the other hand, since the sintered compact which comprises an aluminum nitride as the main ingredients is a polycrystalline substance, and the aluminum nitride crystal grain which constitutes this sintered compact has turned to all directions, there is no directivity of a crystal substantially, it seems that the optical property as a crystal is what was equalized.

It seems that it has impurities dissolution, such as minute amount cation impurities or carbon, oxygen, etc. to the inside of the aluminum nitride particle which constitutes a sintered compact, since the sintered compact which comprises an aluminum nitride as the main ingredients is produced by firing.

Moreover, since the sintered compact which comprises an aluminum nitride as the main ingredients is a polycrystalline substance as mentioned above and a grain boundary and a grain boundary phase exist, it can consider the impurities condensation and deposition to that portion.

An index of refraction lowers from a single crystal as a result of the feature as above sintered compacts, therefore, this inventor thinks that the thin film which comprises as the main ingredients at least one or more materials selected from a gallium nitride, an indium nitride, and an aluminum nitride which are formed directly on the sintered compact which comprises an aluminum nitride as the main ingredients can function enough as an optical waveguide.

Usually, even if it was the thin film which comprises as the main ingredients at least one or more materials selected from a gallium nitride, an indium nitride, and an aluminum nitride which are formed directly on the sintered compact which comprises an aluminum nitride as the main ingredients, as for what was formed as a single crystal, an index of refraction is not less than 2.0, and functions as an optical waveguide enough.

In the single crystal thin film which uses as an optical waveguide and comprises as the main ingredients at least one or more materials selected from a gallium nitride, an indium nitride, and an aluminum nitride, in order to raise the crystallinity of the single crystal thin film comprising an aluminum nitride as the main ingredients, when the homogeneous thin film which comprises as the main ingredients at least one or more materials selected from a gallium nitride, an indium nitride, and an aluminum nitride is used as the intermediate layer to the sintered compact which comprises an aluminum nitride as the main ingredients, as for the refractive index of this intermediate layer thin film, it is preferred to use what is smaller than 2.0.

In this case, it considers that this intermediate layer thin film plays a role of a cladding layer for operating an optical waveguide.

In this invention, this thin film substrate can be used for the substrate for optical transmissions, such as light modulator, optical phase converter, wavelength filter, optical switch, or the acoustic optical device, by providing an electrode to the thin film substrate in which the optical waveguide which consists of a thin film which comprises as the main ingredients at least one or more materials selected from a gallium nitride, an indium nitride, and an aluminum nitride was formed on the sintered compact which comprises an aluminum nitride as the main ingredients.

It seems that it will become possible because the index of refraction of this thin film can be changed by applying potential to the thin film which comprises as the main ingredients at least one or more materials selected from a gallium nitride, an indium nitride, and an aluminum nitride.

As for the currently formed thin film which comprises as the main ingredients at least one or more materials selected from a gallium nitride, an indium nitride, and an aluminum nitride, it is preferred to use a single crystal.

Not only the reason for the ability to be easy to lower the transmission loss, it is for being able to control the direction of the potential to an optical axis (namely, C axis of a crystal), and as a result becoming easy to control the variation of an index of refraction, if this thin film is a single crystal.

An aluminum nitride crystal, a gallium nitride crystal, an indium nitride crystal, or the mixed crystal of these nitrides is an optically anisotropic substance of which the direction perpendicular to an optical axis, i.e., a crystal C axis, is the direction of ordinary light, and the direction parallel to C axis is the direction of extrardinary light, it differs with ordinary light and extraordinary light about an index of refraction, and the extraordinary light is larger.

If a thin film is a single crystal, it becomes easy to control the variation of an index of refraction by making the applying direction of potential parallel to C axis or perpendicular to C axis.

Moreover, in this invention, although the thin film substrate in which the single crystal thin film which comprises as the main ingredients at least one or more materials selected from a gallium nitride, an indium nitride, and an aluminum nitride was formed on the sintered compact which comprises an aluminum nitride as the main ingredients can be provided, the crystallographic-axis formation direction of this single crystal thin film can produce either the direction where C axis is perpendicular, or a level direction to a substrate surface, various index-of-refraction control becomes still more possible.

The effect of using the above single crystals for the thin film which forms an optical waveguide is large in the thin film substrate which has the embedded type optical waveguide of the after-mentioned (for example, FIG. 30, FIG. 31, FIG. 32, FIG. 33, FIG. 35).

In this invention, as mentioned above, a light modulator, an optical phase converter, a wavelength filter, an optical switch, etc. are producible using the property in which the index of refraction of this thin film tends to change, by providing an electrode and applying potential.

As mentioned above, the feature of this invention is in the point that the optical waveguide by the thin film which comprises as the main ingredients at least one or more materials selected from a gallium nitride, an indium nitride, and an aluminum nitride can be formed on the sintered compact which comprises an aluminum nitride as the main ingredients instead of a conventional sapphire substrate.

For example, about the reason in which the above-mentioned characteristics, such that ultraviolet light can transmit under low transmission loss, are acquired as an optical waveguide, that the high junction nature is obtained between the sintered compact which comprises an aluminum nitride as the main ingredients and the thin film which comprises as the main ingredients at least one or more materials selected from a gallium nitride, an indium nitride, and an aluminum nitride, is considered to be one of the main factors.

As a result, it becomes easy to form a thin film with few strains and defects easily.

As for the reason that the characteristics as an optical waveguide are acquired as mentioned above, it also seems that it is one of the main factors that the single crystal thin film which comprises as the main ingredients at least one or more materials selected from a gallium nitride, an indium nitride, and an aluminum nitride can be formed on the sintered compact which comprises an aluminum nitride as the main ingredients.

As mentioned above, a thin film substrate in which the optical waveguide by the thin film which comprises as the main ingredients at least one or more materials selected from a gallium nitride, an indium nitride, and an aluminum nitride was formed on the sintered compact which comprises an aluminum nitride as the main ingredients can be provided according to this invention.

As for an optical waveguide according to this invention, it is producible even if it is the two dimension waveguide and three dimension optical waveguide of what kind of structure which have been found hitherto.

Forming furthermore an electrical circuit to a thin film substrate according to this invention, the thin film substrate can be used as an optical wiring substrate which has an optical waveguide and an electric circuit at least.

Since it excels in junction nature with the thin film which comprises as the main ingredients at least one or more materials selected from a gallium nitride, an indium nitride, and an aluminum nitride, and with the sintered compact which comprises an aluminum nitride as the main ingredients, it is preferred to use the thin film conductivity material according to this invention as a material for forming the above-mentioned electrical circuit.

In addition to this, as the material for forming the above-mentioned electrical circuit, the thing which comprises as the main ingredients tungsten, molybdenum, and copper and which is formed by co-firing with the sintered compact which comprises an aluminum nitride as the main ingredients, or the material which comprises as the main ingredients gold, silver, copper, platinum, palladium, tungsten, molybdenum, manganese, nickel, etc. and which is formed by a thick film printing method to the sintered compact which comprises an aluminum nitride as the main ingredients, or material which comprises as the main ingredients gold, silver, copper, platinum, palladium, and nickel, etc. by the pasting-up method using the resin ingredient as conductive paste to the sintered compact which comprises an aluminum nitride as the main ingredients, etc., can be used.

A figure is illustrated and explained below about the thin film substrate in which the optical waveguide by the thin film which comprises as the main ingredients at least one or more materials selected from a gallium nitride, an indium nitride, and an aluminum nitride was formed on the sintered compact which comprises an aluminum nitride as the main ingredients according to this invention.

FIG. 21-FIG. 23 is an example which shows the thin film substrate in which the two dimension optical waveguide was formed.

FIG. 21 is a perspective diagram showing one example of a thin film substrate in which the two dimension optical waveguide 50 is being formed on the substrate 14 which consists of a sintered compact which comprises an aluminum nitride as the main ingredients by the thin film which comprises as the main ingredients at least one or more materials selected from a gallium nitride, an indium nitride, and an aluminum nitride.

FIG. 22 is a perspective diagram showing one example of the thin film substrate in which the two dimension optical waveguide 50 was formed on the substrate 14 which consists of a sintered compact which comprises an aluminum nitride as the main ingredients by the thin film which comprises as the main ingredients at least one or more materials selected from a gallium nitride, an indium nitride, and an aluminum nitride, and the cladding layer 70 was formed on this two dimension optical waveguide.

In FIG. 22, if a cladding layer is the material with a refractive index smaller than the thin film which comprises as the main ingredients at least one or more materials selected from a gallium nitride, an indium nitride, and an aluminum nitride and which forms an optical waveguide, anything can use, for example, SiO₂, Al₂O₃, various glass, etc., it is preferred, to use a homogeneous material which comprises as the main ingredients at least one or more materials selected from a gallium nitride, an indium nitride, and aluminum nitride from the point of junction nature, etc.

In FIG. 22, a cladding layer can use air, the thin film substrate which is shown in FIG. 22 will become equivalent to the thin film substrate shown in FIG. 21 in that case.

FIG. 23 is perspective diagram showing one example of the thin film substrate in which a cladding layer 70 is formed on the substrate 14 which consists of a sintered compact which comprises an aluminum nitride as the main ingredients, and the two dimension optical waveguide 50 is being formed on it by the thin film which comprises as the main ingredients at least one or more materials selected from a gallium nitride, an indium nitride, and an aluminum nitride.

In FIG. 23, if a cladding layer is the material with a refractive index smaller than the thin film which comprises as the main ingredients at least one or more materials selected from a gallium nitride, an indium nitride, and an aluminum nitride and which form an optical waveguide, anything can be used, for example, SiO₂, Al₂O₃, various glass, etc., it is preferred to use a homogeneous material which comprises as the main ingredients at least one or more materials selected from a gallium nitride, an indium nitride, and an aluminum nitride, from the point of junction nature, etc.

In FIG. 21-FIG. 23, when light is introduced into the thin film which is formed in the shape of a plate and comprises as the main ingredients at least one or more materials selected from a gallium nitride, an indium nitride, and an aluminum nitride, an introductory light is confined in the perpendicular direction of a substrate, and this thin film functions as a two dimension optical waveguide.

FIG. 24-FIG. 30 is an example which shows the thin film substrate in which the three dimension optical waveguide was formed.

FIG. 24 is a perspective diagram showing one example of the thin film substrate in which the three dimension optical waveguide 60 is being formed on the substrate 14 which consists of a sintered compact which comprises an aluminum nitride as the main ingredients by the thin film which comprises as the main ingredients at least one or more materials selected from a gallium nitride, an indium nitride, and an aluminum nitride.

In FIG. 24, the circumference of the three dimension optical waveguide 60 is air.

FIG. 25 is a perspective diagram showing one example of the thin film substrate in which a cladding layer 70 is formed on the substrate 14 which consists of a sintered compact which comprises an aluminum nitride as the main ingredients, and the three dimension optical waveguide 60 is being formed on it by the thin film which comprises as the main ingredients at least one or more materials selected from a gallium nitride, an indium nitride, and an aluminum nitride.

In FIG. 25, if a cladding layer is the material with a refractive index smaller than the thin film which comprises as the main ingredients at least one or more materials selected from a gallium nitride, an indium nitride, and an aluminum nitride and which forms an optical waveguide, anything can be used, for example, SiO₂, Al₂O₃, various glass, etc., it is preferred to use a homogeneous material which comprises as the main ingredients at least one or more materials selected from a gallium nitride, an indium nitride, and an aluminum nitride, from points of junction nature etc.

FIG. 26 is a perspective diagram showing one example of a thin film substrate in which the three dimension optical waveguide 61 is being formed on the substrate 14 which consists of a sintered compact which comprises an aluminum nitride as the main ingredients by the thin film which comprises as the main ingredients at least one or more materials selected from a gallium nitride, an indium nitride, and an aluminum nitride which is formed in the shape of a ridge (back of a mountain).

It is desirable to use material with a refractive index smaller than this optical waveguide, for example, what comprises as the main ingredients at least one or more materials selected from a homogeneous gallium nitride, an indium nitride, and an aluminum nitride between the substrate 14 which consists of a sintered compact which comprises an aluminum nitride as the main ingredients and the ridge-like three dimension optical waveguide 61 in order to lower optical transmission loss, although not illustrated in FIG. 26.

FIG. 27 is a perspective diagram showing one example of a thin film substrate in which the two dimension optical waveguide 50 is produced on the substrate 14 which consists of a sintered compact which comprises an aluminum nitride as the main ingredients by forming the thin film which comprises as the main ingredients at least one or more materials selected from a gallium nitride, an indium nitride, and an aluminum nitride in the shape of a plate, the dielectric material 40, such as SiO₂, Al₂O₃, and various glass, is formed in this two dimension optical waveguide, the three dimension optical waveguide 62 is made by raising the refractive index of the two dimension optical waveguide of a portion in which this dielectric material was formed.

It is desirable to use material with a refractive index smaller than this optical waveguide, for example, what comprises as the main ingredients at least one or more materials selected from a homogeneous gallium nitride, an indium nitride, and an aluminum nitride between the substrate 14 which consists of a sintered compact which comprises an aluminum nitride as the main ingredients and the two dimension optical waveguide 50 and the three dimension optical waveguide 62 in order to lower optical transmission loss, although not illustrated in FIG. 27.

FIG. 28 is a perspective diagram showing one example of a thin film substrate in which the two dimension optical waveguide 50 is produced on the substrate 14 which consists of a sintered compact which comprises an aluminum nitride as the main ingredients by forming the thin film which comprises as the main ingredients at least one or more materials selected from a gallium nitride, an indium nitride, and an aluminum nitride in the shape of a plate, the metal material 100 is directly formed in this two dimension optical waveguide, by making low the refractive index of the two dimension optical waveguide of a portion in which this metal material was formed, the refractive index of the portion in which this metal is not formed relatively is raised, and the three dimension optical waveguide 63 is produced.

It is desirable to use material with a refractive index smaller than this optical waveguide, for example, what comprises as the main ingredients at least one or more materials selected from a homogeneous gallium nitride, an indium nitride, and an aluminum nitride between the substrate 14 which consists of a sintered compact which comprises an aluminum nitride as the main ingredients and the two dimension optical waveguide 50 and the three dimension optical waveguide 63 in order to lower optical transmission loss, although not illustrated in FIG. 28.

FIG. 29 is a perspective diagram showing one example of a thin film substrate in which the two dimension optical waveguide 50 is produced on the substrate 14 which consists of a sintered compact which comprises an aluminum nitride as the main ingredients by forming the thin film which comprises as the main ingredients at least one or more materials selected from a gallium nitride, an indium nitride, and an aluminum nitride in the shape of a plate, further for example, the buffer layer 110 is formed of material with a refractive index smaller than the thin film that comprises as the main ingredients at least one or more materials selected from a gallium nitride, an indium nitride, and an aluminum nitride, such as SiO₂, Al₂O₃, and various glass, etc., the three dimension optical waveguide 64 is formed raising the refractive index of the two dimension optical waveguide of the portion of the electrode 91 in which high potential is applied applying potential between these electrodes.

It is desirable to use material with a refractive index smaller than this optical waveguide, for example, what comprises as the main ingredients at least one or more materials selected from a homogeneous gallium nitride, an indium nitride, and an aluminum nitride between the substrate 14 which consists of a sintered compact which comprises an aluminum nitride as the main ingredients and the two dimension optical waveguide 50 and the three dimension optical waveguide 64 in order to lower optical transmission loss, although not illustrated in FIG. 29. FIG. 30 is a perspective diagram showing one example of a thin film substrate in which an embedded type of three dimension optical waveguide 65 is being formed in the thin film 80 which comprises as the main ingredients at least one or more materials selected from a gallium nitride, an indium nitride, and an aluminum nitride in the substrate 14 which consists of a sintered compact which comprises an aluminum nitride as the main ingredients.

In FIG. 30, a three dimension optical waveguide 65 is embedded in the inside of the thin film 80 with a refractive index smaller than this waveguide, and it functions as an embedded type of three dimension optical waveguide because the part touches air in the substrate surface.

In FIG. 30, an optical waveguide 65 is obtained by laminating the thin film whose refractive index is larger than a thin film 80 and which comprises as the main ingredients at least one or more materials selected from a gallium nitride, an indium nitride, and an aluminum nitride in this slot, after slot processing is carried out in the thin film 80 which comprises as the main ingredients at least one or more materials selected from a gallium nitride, an indium nitride, an aluminum nitride.

In FIG. 30, an embedded type of optical waveguide 65 is producible by forming a portion with a larger refractive index than a thin film 80 in the inside of a thin film 80, after at least one or more ingredients selected from gallium, indium, niobium, and tantalum are made to contain in the thin film 80 which comprises as the main ingredients at least one or more materials selected from a gallium nitride, an indium nitride, and an aluminum nitride.

This portion to which the refractive index became large uses as an optical waveguide 65.

Methods, such as the above-mentioned thermal diffusion and ion implantation, can be used as a method of making to contain at least one or more ingredients selected from gallium, indium, niobium, and tantalum in the thin film 80 which comprises as the main ingredients at least one or more materials selected from a gallium nitride, an indium nitride, and an aluminum nitride. That is, the space which arrives at this thin film surface is formed, after resist is applied to the thin film 80 which comprises as the main ingredients at least one or more materials selected from a gallium nitride, an indium nitride, and an aluminum nitride which is formed on the substrate 14 which consists of a sintered compact which comprises an aluminum nitride as the main ingredients, and only the size of the width of an optical waveguide 65 removes resist with optical lithography.

In a thermal diffusion method, an optical waveguide can be formed for example, using the above-mentioned lift-off method.

That is, the space which arrives at this thin film surface is formed removing a resist of only the size of the width of an optical waveguide 65 by optical lithography, the thin film which contains an ingredient of gallium, or indium, or niobium, or tantalum is formed through this space by methods, such as sputtering, and vacuum deposition or CVD, if a resist is removed after that, the thin film which contains an ingredient of gallium, or indium, or niobium, or tantalum remains only the width of an optical waveguide 65 in the thin film 80 surface which comprises as the main ingredients at least one or more materials selected from a gallium nitride, an indium nitride, and an aluminum nitride, if high temperature heat-treatment is carried out in the state, an ingredient of gallium, or indium, or niobium, or tantalum will be diffused in the thin film 80 which comprises as the main ingredients at least one or more materials selected from a gallium nitride, an indium nitride, and an aluminum nitride, an optical waveguide 65 is formed in the state where it was embedded in this thin film 80.

In ion implantation method, ion containing an ingredient of gallium, or indium, or niobium, or tantalum will be implanted through the space which is formed in the resist formed by the above-mentioned method, and an optical waveguide 65 is formed in the state where it was embedded in this thin film 80 by carrying out heat treatment suitably.

Although not illustrated in FIG. 30, optical transmission loss becomes easy to lower by further forming a homogeneous thin film which comprises as the main ingredients at least one or more materials selected from a gallium nitride, an indium nitride, and an aluminum nitride between the substrate 14 which consists of a sintered compact which comprises an aluminum nitride as the main ingredients and the thin films 80, it is preferred.

FIG. 31-FIG. 33 shows the example by which the electrode was formed in the thin film substrate which has an optical waveguide.

In FIG. 31-FIG. 33, an optical waveguide is illustrated by using an embedded type indicated in FIG. 30.

In this invention, as mentioned above, an optical modulator, an optical switch, etc. are producible by using the character in which the refractive index of this thin film tends to change, by providing an electrode and applying potential.

The thin film substrate in which an electrode was formed and which has the optical waveguide and is illustrated in FIG. 31-FIG. 33 is shown as an example of the thin film substrate which has such function.

In the thin film substrate which has an embedded type of optical waveguide, in the domain of an optical waveguide with many contents of gallium or indium, or in the domain of the optical waveguide containing an ingredient of niobium or tantalum, a still bigger refractive-index change tends to be obtained by applying of the above-mentioned potential.

FIG. 31 is a perspective diagram showing one example of the thin film substrate in which an embedded type of three dimension optical waveguide 65 is formed in the thin film 80 which comprises as the main ingredients at least one or more materials selected from a gallium nitride, an indium nitride, and an aluminum nitride in the substrate 14 which consists of a sintered compact which comprises an aluminum nitride as the main ingredients, and an electrode 120 is being formed furthermore on the surface of a thin film 80 so that it may sandwich an optical waveguide 65.

Since the thin film substrate shown in FIG. 31 can do the modulation of an optical phase, the modulation of light wavelength, the modulation of optical amplitude, etc. by applying potential to an electrode and changing a refractive index to it, it is applicable to an optical phase modulation machine etc.

FIG. 32 is a perspective diagram showing the example of the thin film substrate in which an embedded type of three dimension optical waveguide 65 is formed in the thin film 80 which comprises as the main ingredients at least one or more materials selected from a gallium nitride, an indium nitride, and an aluminum nitride, in the substrate 14 which consists of a sintered compact which comprises an aluminum nitride as the main ingredients, the electrode 120 is being formed furthermore in the thin film 80 and the optical waveguide 65.

Since the thin film substrate shown in FIG. 32 can do the modulation of an optical phase, the modulation of light wavelength, the modulation of optical amplitude, etc. by applying potential to an electrode and changing a refractive index to it, it is applicable to an optical phase modulation machine etc.

FIG. 32 is a perspective diagram showing the example of the thin film substrate in which an embedded type of three dimension optical waveguide 65 is formed in the thin film 80 which comprises as the main ingredients at least one or more materials selected from a gallium nitride, an indium nitride, and an aluminum nitride, in the substrate 14 which consists of a sintered compact which comprises an aluminum nitride as the main ingredients, the electrode 120 is being formed furthermore in the optical waveguide 65.

Since the thin film substrate shown in FIG. 32 can do the modulation of an optical phase, the modulation of light wavelength, the modulation of optical amplitude, etc. by applying potential to an electrode and changing a refractive index to it, it is applicable to an optical phase modulation machine and optical switch, such as a transmission way change, etc.

Although any material can be used as an electrode 120 in FIG. 31-FIG. 33, it is preferred to use the above-mentioned thin film conductivity material according to this invention, since junction reliability with the thin film which comprises as the main ingredients at least one or more materials selected from a gallium nitride, an indium nitride, and an aluminum nitride are high.

It is desirable to form a buffer layer by material with a refractive index smaller than the thin films 80 and an optical waveguide 65, such as SiO₂, Al₂O₃, and various glass, etc., between a thin film 80 and an electrode 120 and between an optical waveguide 65 and an electrode 120 in order to lower transmission loss, although not shown in FIG. 31-FIG. 33.

Although not illustrated in FIG. 31-FIG. 33, it is desirable to form further the homogeneous thin film which comprises as the main ingredients at least one or more materials selected from a gallium nitride, an indium nitride, and an aluminum nitride between the substrate 14 which consists of a sintered compact which comprises an aluminum nitride as the main ingredients and the thin films 80, since it becomes easy to lower transmission loss.

FIG. 34 and FIG. 35 show the example of the thin film substrate in which the electric circuit was formed furthermore simultaneously in the thin film substrate according to this invention which has an optical waveguide.

The thin film substrate wich is illustrated in FIG. 34 and FIG. 35 can be used as an optical wiring substrate which can transmit both electricity and light.

FIG. 34 is a perspective diagram showing one example of the thin film substrate in which the cladding layer 71 which comprises as the main ingredients at least one or more materials selected from a gallium nitride, an indium nitride, and an aluminum nitride is formed on the substrate 14 which consists of a sintered compact which comprises an aluminum nitride as the main ingredients and the three dimension waveguide 60 is being formed on it.

The electric circuit 12 is being simultaneously formed in the portion 14 of a sintered compact which comprises an aluminum nitride as the main ingredients.

When lowering transmission loss of light, as for the refractive index of a cladding layer, it is preferred that it is smaller than the refractive index of an optical waveguide.

FIG. 35 is a perspective diagram showing one example of a thin film substrate in which an embedded type of three dimension optical waveguide 65 is being formed in the thin film 80 which comprises as the main ingredients at least one or more materials selected from a gallium nitride, an indium nitride, and an aluminum nitride in the substrate 14 which consists of a sintered compact which comprises an aluminum nitride as the main ingredients.

The electric circuit 12 is being simultaneously formed in a part of this thin film 80.

Although not illustrated in FIG. 35, it is desirable to form further the homogeneous thin film which comprises as the main ingredients at least one or more materials selected from a gallium nitride, an indium nitride, and an aluminum nitride between the substrate 14 which consists of a sintered compact which comprises an aluminum nitride as the main ingredients and the thin films 80, since it becomes easy to lower transmission loss.

Light is usually introduced into an optical waveguide from the external side of this optical waveguide, and it is emitted from other external sides..

The advance situation of an introductory light into the optical waveguide which is guessed is shown in FIG. 30 by the dotted line and the arrow.

That is, light 66 is horizontally introduced to the interface of this optical waveguide and the thin film layer 80 from the portion of side 65′ of an optical waveguide 65 shown in FIG. 30, and it seems that it goes on along this optical waveguide within an optical waveguide as a dotted line shows, and it is emitted as light 66′ from the side of opposite.

Even if it is the optical waveguide produced by forming directly the thin film which comprises as the main ingredients at least one or more materials selected from a gallium nitride, an indium nitride, and an aluminum nitride on the substrate which consists of a sintered compact which comprises an aluminum nitride as the main ingredients not only the optical waveguide produced in the inside of a thin film which comprises as the main ingredients at least one or more materials selected from a gallium nitride, an indium nitride, and an aluminum nitride which is formed on the substrate which consists of a sintered compact which comprises an aluminum nitride as the main ingredients, like the optical waveguide shown in FIG. 30, there is little transmission loss.

Since the direction of the light introduced is a horizontal direction to the interface between an optical waveguide and a substrate as the cause, it also seems that that it is hard to produce the penetration of an introductory light by this sintered compact which comprises an aluminum nitride as the main ingredients and the absorption and cattering of light by grain boundary phase by the crystal grain, grain boundary or an additive in this sintered compact, in the interface of this sintered compact and the above-mentioned thin film which comprises as the main ingredients at least one or more materials selected from a gallium nitride, an indium nitride, and an aluminum nitride, and, etc. is the cause that transmission loss is small even if it uses the sintered compact which comprises an aluminum nitride as the main ingredients.

The action of the light introduced in such an optical waveguide is considered to be the same also not only in the three dimension optical waveguide according to this invention illustrated in FIG. 30 but also in a two dimensional optical waveguide.

The thing of any sizes can be used as an optical waveguide according to this invention, if width is not less than 0.5 μm and depth (or thickness) is not less than 0.1 μm, it will function enough.

In the three dimension waveguide according to this invention illustrated in FIG. 24-FIG. 35, if usually width is not less than 1 μm and depth (or thickness) is not less than 0.3 μm, it will function enough.

The light emitting device excellent in luminous efficiency is producible using the substrate which consists of a sintered compact which comprises an aluminum nitride as the main ingredients, or the thin film substrate in which a thin film which comprises as the main ingredients at least one or more materials selected from a gallium nitride, an indium nitride, and an aluminum nitride and has various crystallized states, such as an amorphous state, a polycrystal, an orientated polycrystal, and a single crystal etc., was formed on the substrate which consists of a sintered compact which comprises an aluminum nitride as the main ingredients according to this invention.

The light emitting device which is formed on such substrate is manufactured usually by epitaxially growing the thin film of the target composition, after decomposing or not decomposing chemically physically the compound and simple substance containing at least a part of target chemical entity, then making it into gas, ion, or a molecular beam in the state as it is, it is made to react or not to react with the compound except the above suitably, once making the ingredient containing the target chemical entity into the gaseous phase by the above-mentioned method, such as MOCVD method, an MOVPE method, a Hydride VPE method, a Halide VPE method containing a Chloride VPE method, a Plasma CVD method, other CVD method (Chemical Vapor Phase Deposition)s, an MBE method (Molecular Beam Epitaxy), or a laser ablation method uses the Excimer laser etc. and uses as a raw material the solid material containing the purpose ingredient which was formed beforehand, a PLD method (Pulse Laser Deposition: Pulse Laser Deposition), a Sputtering method, an Ion-plating method, or a Vacuum deposition etc., by usually using metal organic compounds, such as trimethyl gallium, trimethyl indium, and trimethyl aluminum etc., halogenated compounds, such as a gallium chloride, an indium chloride, and aluminum chloride etc., and nitrogen containing compounds, such as ammonia etc., as the main raw materials, in addition, silane compounds, such as SiH and SiH etc., and organic metallic compounds, such as dimethyl magnesium and Bis-cyclopentadienyl magnesium etc., as materials for doping elements.

The constitution of a light emitting device is what laminated at least N type semiconductor layer and the luminescence layer which consists of an quantum well structure, etc. and P type semiconductor layer in about 0.5 nm-several μm respectively as the thickness, by usually using the thin film of various compositions which comprises as the main ingredients at least one or more materials selected from a gallium nitride, an indium nitride, and an aluminum nitride and is epitaxially grown from the materials illustrated above on the substrate, then a luminescence function is generated.

The above-mentioned N type semiconductor layer, luminescence layer, and P type semiconductor layer are the fundamental constituent factor in order to generate a luminescence of the luminescence layer.

This invention has the feature in the point which constituted the light emitting device by laminating at least the above-mentioned N type semiconductor layer, the luminescence layer, and P type semiconductor layer on the sintered compact which comprises an aluminum nitride as the main ingradient or on the substrate which is made from this sintered compact, and making a laminated body.

The above-mentioned N type semiconductor layer usually contains donor formation doping agents, such as Si, Ge, Se, Te, and O, other than the main ingredients.

P type semiconductor layer usually contains acceptor formation doping agents, such as Mg, Be, Ca, Zn, Cd, and C, other than the main ingredients.

The above-mentioned N type semiconductor layer, the luminescence layer, and P type semiconductor layer are the fundamental constituent factor of a light emitting device, and the epitaxially grown single crystal thin film is usually used, in addition to this single crystal, even if it is what is various crystallized states, such as an amorphous state, a polycrystal, and an orientated polycrystal, suitably, it can use.

In addition, the buffer layer (buffer layer) which is between a substrate and this N type semiconductor layer, or between a substrate and P type semiconductor layer is also suitably used if needed in addition to the above-mentioned N type semiconductor layer, a luminescence layer, and P type semiconductor layer as a constituent factor of a light emitting device.

This buffer layer is usually formed from the thin film which comprises as the main ingredients at least one or more materials selected from a gallium nitride, an indium nitride, an aluminum nitride.

Although what is various crystallized states, such as an amorphous state, a polycrystal, an orientated polycrystal, and a single crystal, can be used as the thin film which constitutes this buffer layer, usually, what is at least one of the crystallized states selected from an amorphous state, a polycrystal, and an orientated polycrystal is used.

What is the epitaxially grown single crystal can also be used.

Light emission (Light Emission), such as green-blue color, or blue color, or a purple-blue color, or ultraviolet rays, or, for example, white color luminescence by using together the phosphor which comprises YAG (yttrium aluminum Garnett) as the main ingredients, or the light by laser oscillation, is obtained by applying about several mW—several W direct-current electric power into such light emitting device.

When producing the above-mentioned light emitting device, the thin film formation of various crystallized states, such as an amorphous state, a polycrystal, an orientated polycrystal, and a single crystal, is usually performed under the substrate temperature of about 400 degrees C-1300 degrees C.

Or it is suitably performed under the low substrate temperatur comparatively, such as room temperature −400 degrees C.

It may be effective to perform at low substrate temperature, when controlling the crystal growth of the thin film formed on a substrate and controlling a crystal direction.

In the case of the doping element for forming P type semiconductors, such as Mg, it is preferred to perform annealing above 400 degrees C in non-oxidizing atmosphere, such as nitrogen which does not contain hydrogen as much as possible after single crystal thin film formation, in order to form P type single crystal thin film of low resistance.

In this invention, that whose thin film which comprises as the main ingredients at least one or more materials selected from a gallium nitride, an indium nitride, and an aluminum nitride and which is various crystallized state, such as an amorphous state, a polycrystal, an orientated polycrystal, and a single crystal etc., and is directly formed on the substrate which consists of a sintered compact which comprises an aluminum nitride as the main ingredients is being formed as a part of layer which constitutes a light emitting device as P type semiconductor layer, a luminescence layer, or N type semiconductor layer, is also contained.

The light emitting device using the above-mentioned thin film which comprises as the main ingredients at least one or more materials selected from a gallium nitride, an indium nitride, and an aluminum nitride and which is various crystallized states, such as an amorphous state, a polycrystal, an orientated polycrystal, and a single crystal etc., and is directly formed on the substrate which consists of a sintered compact which comprises an aluminum nitride as the main ingredients, is also contained in this invention.

In order to raise luminous efficiency, it is preferred that each thin film layer of N type semiconductor layer, a luminescence layer, and P type semiconductor layer which constitute a light emitting device should usually be the single crystal thin film of high crystallinity which grew epitaxially and comprises as the main ingredients at least one or more materials selected from a gallium nitride, an indium nitride, and an aluminum nitride.

In order to raise more the crystallinity of the single crystal thin film which constitutes this light emitting device in this invention, although it is preferred to form the thin film which comprises as the main ingredients at least one or more materials selected from a gallium nitride, an indium nitride, and an aluminum nitride which is formed beforehand on the substrate which consists of a sintered compact which comprises an aluminum nitride as the main ingredients before forming this single crystal thin film, the thin film which is formed beforehand on this substrate which consists of a sintered compact which comprises an aluminum nitride as the main ingredients can use them, no matter not only a single crystal but also an amorphous state, a polycrystal, an orientated polycrystal, etc. may be in what crystallized states.

As for the above-mentioned N type semiconductor layer, not only a single layer but also what is constituted from at least two or more thin film layers, such as a cladding layer which is connected with a luminescence layer and a contact layer to connect with an electrode, is used suitably.

As for the above-mentioned contact layer and cladding layer which constitute N type semiconductor layer, not only a single layer but also what is constituted from at least two or more thin film layers is also used suitably.

As for a luminescence layer, not only a single layer like a hetero structure or a double hetero structure or single quantum well structure but also what is constituted from at least two or more thin film layers, for example, like multi-quantum-well structure, is also used suitably.

As for P type semiconductor layer, not only a single layer but also what comprises at least two or more thin film layers, such as a contact layer to connect with an electrode and a cladding layer which is connected with a luminescence layer, is used suitably.

As for the above-mentioned contact layer and cladding layer which constitute P type semiconductor layer, not only a single layer but also what is constituted from at least two or more thin film layers is also used suitably.

When forming the light emitting device on the substrate, usually, it is preferred not to form a contact layer on a substrate immediately, but to form the contact layer which has N semiconductor characteristic or P type semiconductor characteristic after forming the buffer layer (buffer layer) which consists of a thin film which comprises as the main ingredients at least one or more materials selected from a gallium nitride, an indium nitride, and an aluminum nitride between the substrate and the contact layer.

As for the thin film which forms this buffer layer, what comprises as the main ingredients at least one or more materials selected from a gallium nitride, an indium nitride, and an aluminum nitride and is various crystallized states, such as an amorphous state, a polycrystal, an orientated polycrystal, and a single crystal, can use, usually what is the crystallized states, such as an amorphous state, a polycrystal, and an orientated polycrystal etc., is used.

It can use, even if it is the epitaxially grown single crystal thin film of high crystallinity.

This buffer layer can be used also in the state where a doping element is not included, it can be used suitably also in the state of making a doping element contain and having N type semiconductor characteristic or P type semiconductor characteristic.

The feature of a light emitting device according to this invention is in the point of having used the sintered compact which comprises an aluminum nitride as the main ingredients as the substrate.

If it says in detail, there are at least two kinds of substrates as the substrate according to this invention for producing a light emitting device, that is, what used the sintered compact which comprises an aluminum nitride as the main ingredients as a substrate as it is, and what formed at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., onto the substrate which was made with a sintered compact which comprises an aluminum nitride as the main ingredients.

Moreover, this thin film substrate includes the thin film substrate in which a single crystal thin film which comprises as the main ingredients at least one or more materials selected from a gallium nitride, an indium nitride, and an aluminum nitride was formed furthermore on it after at least one or more layers of the thin films which comprise as the main ingredients at least one or more materials selected from a gallium nitride, an indium nitride, and an aluminum nitride and which have at least one of crystal states selected from an amorphous state, a polycrystal, an orientated polycrystal, and a single crystal etc. was formed beforehand on the substrate which consists of a sintered compact which comprises an aluminum nitride as the main ingredients.

While the luminous efficiency of the light emitting device which is produced using conventional single crystal substrates, such as sapphire etc., is usually about 2%-8%, at least equivalent or what is a maximum of not less than 4-5 times is obtained as luminous efficiency of the light emitting device according to this invention which was produced using as a substrate the sintered compact which comprises an aluminum nitride as the main ingredients.

That is, in the case of a light emitting device according to this invention, a maximum of not less than 30-40% of the applied electric power may be emitted to the exterior of a light emitting device as optical energy.

The luminous efficiency in this invention is a percentage ratio of the electric power which was applied in order to make a light emitting device drive and the optical output which was actually emitted from a light emitting device.

For example, that luminous efficiency is 10% means that 180 mW is obtained as an optical output, when the voltage of 3.6 volts and 500 mA of current are applied in order to drive it, in case of the light emitting device of the quantum well structure in which a luminescence layer comprises GaN as the main ingredients.

An optical output can be calculated, for example, by measuring the optical energy which was collected by using the spectrophotometer etc. after collecting all emitted the light by making to emit light by setting a light emitting device in an integrating sphere.

Although it is not necessarily clear about the cause in which a light emitting device produced using the substrate according to this invention which consists of a sintered compact which comprises an aluminum nitride as the main ingredients has high luminous efficiency, a single crystal thin film of high crystallinity which constitutes a device and comprises as the main ingredients at least one or more materials selected from a gallium nitride, an indium nitride, and an aluminum nitride can be formed now on the substrate which consists of a sintered compact which comprises an aluminum nitride as the main ingredients, therefore, it is certain that it is that a single crystal thin film excellent in such crystallinity can be used now as at least N type semiconductor layer, a luminescence layer, and P type semiconductor layer of a light emitting device is important for the first.

However, it seems that the cause in which a light emitting device according to this invention has higher luminous efficiency than what used single crystal substrates, such as sapphire etc., is not only that but also a big contribution of resulting from a microstructure of the sintered compact which comprises an aluminum nitride as the main ingredients and is used as a substrate.

As a result of this inventor's examination, the single crystal thin film which comprises as the main ingredients at least one or more materials selected from a gallium nitride, an indium nitride, and an aluminum nitride and which has the crystallinity whose half width of the rocking curve of the X-ray diffraction line from the lattice plane of a Miller Index (002) is at least not more than 300 seconds can be formed on a sapphire substrate as well as the substrate which consists of a sintered compact which comprises an aluminum nitride as the main ingredients.

Conventionally, the light emitting device has been manufactured by forming the single crystal thin film excellent in such crystallinity so that each layer of N type semiconductor layer, luminescence layer, and P type semiconductor layer may be constituted at least after forming a buffer layer first on substrates, such as sapphire etc., if it requires.

On the other hand, as explained until now in this invention, the single crystal thin film of excellent crystallinity which comprises as the main ingredients at least one or more materials selected from a gallium nitride, an indium nitride, and an aluminum nitride which is at least equivalent to a conventional single crystal substrate, such as sapphire etc., or more than it can be formed also on the substrate which consists of a sintered compact which comprises an aluminum nitride as the main ingredients, this single crystal thin film can be formed at least as N type semiconductor layer, a luminescence layer, P type semiconductor layer, or a buffer layer, respectively so that it may function as a light emitting device.

In this invention, when a light emitting device is produced with the same film constitution by using the thin film which comprises as the main ingredients at least one or more materials selected from a gallium nitride, an indium nitride, and an aluminum nitride, if the case whose sintered compact which comprises an aluminum nitride as the main ingredients is used is compared with the case whose conventional sapphire etc. is used as a substrate, when the substrate which consists of a sintered compact which comprises an aluminum nitride as the main ingredients is used, it is at least equivalent or is as high as a maximum of not less than 4 times-5 times if it is compared with the case where conventional sapphire etc. is used as a substrate.

Speaking concretely, by using the conventional sapphire and the sintered compact which comprises an aluminum nitride as the main ingredients as a substrate, when the light emitting device which has N type semiconductor layer, a luminescence layer, P type semiconductor layer of the same constitution, or a buffer layer if needed is produced on these substrates by the thin film which comprises as the main ingredients at least one or more materials selected from a gallium nitride, an indium nitride, and an aluminum nitride, as for the thin film which constitutes at least this N type semiconductor layer, a luminescence layer and P type semiconductor layer among these thin film layers that constitute an optical element, even if it is the single crystal which has the same crystallinity, for example 150 seconds as half width of the rocking curve of the X ray diffraction line from the lattice plane of a Miller Index (002), the luminous efficiency of the light emitting device which was produced by using as a substrate the substrate which consists of a sintered compact which comprises an aluminum nitride as the main ingredients is at least equivalent or is as high as a maximum of not less than 4 times - 5 times if it is compared with the case where conventional sapphire is used as a substrate.

Therefore, it is even if it is important conditions for the first that the single crystal thin film of excellent crystallinity can be formed on the substrate which consists of a sintered compact which comprises an aluminum nitride as the main ingredients when producing the light emitting device of high luminous efficiency as mentioned above, it seems that the luminous efficiency of the light emitting device which was produced by using the substrate which consists of a sintered compact which comprises an aluminum nitride as the main ingredients so then is equivalent to conventional substrates, such as sapphire etc., at least, or does not become still higher than it.

Since the sintered compact which comprises an aluminum nitride as the main ingredients has the microstructure which is being constituted by sintering the crystal grain or grain boundary phase which comprises an aluminum nitride as the main ingredients, solidify, other than the original characteristic, such as an optical absorption end being near the wavelength 200 nm or a refractive index being close to a gallium nitride, unlike a transparent body like sapphire, it seems that it is hard to produce reflection in the interface of a sintered compact and a thin film, or the interface of a sintered compact and exterior space.

That is, since it is hard to produce such light reflex, it seems that what was irradiated directly at the interface of the above-mentioned sintered compact and a thin film, or also light which was irradiated at the above-mentioned interface by being reflected from the thin film surface which is directly in contact with exterior space, not being at a substrate side among the thin films which constitute the light emitting device, almost trespasses upon the inside of a sintered compact which usees an aluminum nitride as the main ingredients without being reflected, then the light which reached the interface of this sintered compact which comprises an aluminum nitride as the main ingredients and exterior space is emitted to the exterior of the device.

When optical permeability is compared between the sapphire substrate and the substrate which consists of a sintered compact which comprises an aluminum nitride as the main ingredients, while permeability is shown to the light up to the wavelength 210-220 nm even if it is what is most excellent in the case of the substrate which consists of a sintered compact which comprises an aluminum nitride as the main ingredients, and it shows the optical transmissivity not less than 80% in the light with 330 nm wavelength, in the case of a sapphire substrate, it is usually transparent to the ultraviolet area near the wavelength 150 nm, optical transmissivity is also 80%-90% in the range of 200 nm-4500 nm wavelength, since it is a transparent body it is easy to penetrate light linearly, therefore, the sapphire substrate seems to excel the substrate which consists of a sintered compact which comprises an aluminum nitride as the main ingredients in respect of optical permeability.

Therefore, if it sees from the point of optical permeability, it will seem that more light which is emitted from the luminescence layer of a light emitting device is emitted to the exterior of a device when a sapphire substrate is used rather than the substrate which consists of a sintered compact which comprises an aluminum nitride as the main ingredients, but it is the contrary in practice.

Even if it is the case where what does not have optical permeability among the sintered compacts which comprise an aluminum nitride as the main ingredients is used as a substrate, since the luminous efficiency of the light emitting device which is formed on this substrate was equivalent or more to a sapphire substrate, it seems that the light which was emitted from the luminescence layer of a light emitting device is probably reflected at the interface of a sapphire substrate and a thin film, or the interface of a sapphire substrate and exterior space, and it hardly penetrates a sapphire substrate.

If saying in other words, when a sapphire substrate is used, it is surmised that the light which was emitted from the luminescence layer of a light emitting device is probably reflected at the above-mentioned each interface, and is returned to the inside of a device, so it is hard to be emitted to the exterior of a device by penetrating a sapphire substrat.

Moreover, as for light which was irradiated at the above-mentioned each interface by reflecting from the thin film surface which is directly in contact with exterior space, not from the thin film surface of a sapphire substrate side, among the thin films which constitute the light emitting device among the light which was emitted from the light emitting device, almost all was also reflected and reaches the thin film surface which is directly in contact with exterior space again, the repetition of being reflected at this thin film surface again arises, it is conjectured that as the result, the light emitted to the exterior from this thin film surface also tends to decrease than the case where the sintered compact which comprises an aluminum nitride as the main ingredients and which does not have optical permeability is used as a substrate.

The sizes of the outside of a light emitting device are about 0.05 mm square-10 mm square, usually about 0.1 mm square-3 mm square, and when the thickness of the thin film layer which constitutes a light emitting device is totaled, it is about 0.5 μm-50 μm, susually about 1 μm-20 μm.

Moreover, since it seems that the luminescence layer of a light emitting device is the shape of a plane, and the light which was emitted from this luminescence layer is irradiated to the substrate surface which faces each other perpendicularly in about 0.5 μm-50 μm distance, although it seems that it is hard to produce phenomena, such as total reflection, in the interface of a substrate and a thin film which constitutes a light emitting device originally, it seems that in the case of a sapphire substrate, in the wavelength 650 nm, th refractive index is 1.76 and is low if it is compared with a gallium nitride, an indium nitride, and an aluminum nitride which constitute a thin film, further because it is a single crystal there are not a grain boundary and a grain boundary phase, it is homogeneous, and it becomes easy to produce the reflection in the above-mentioned interface by that whose high smooth nature of the substrate surface becomes a cause.

Since the luminous efficiency of the light emitting device which is formed on this substrate is equivalent to what used the sapphire substrate, or is more excellent, even if it uses as a substrate what does not have optical permeability among the sintered compacts which comprise an aluminum nitride as the main ingredients as mentioned above, it was conjectured, that much dislocation or distortion by the lattice mismatching, or the difference of thermal expansion coefficient are in the thin film in case of a sapphire substrate is the cause which lowers luminous efficiency like it has been said hitherto.

On the other hand, when the sintered compact which comprises an aluminum nitride as the main ingredients as a substrate is used, since the refractive index of an aluminum nitride is 2.00-2.25 in the wavelength 650 nm, and is comparatively close to a gallium nitride, an indium nitride which constitute a light emitting device other than an aluminum nitride, the crystal grain which comprises an aluminum nitride as the main ingredients, a grain boundary, or the grain boundary phase by an additive etc. in the sintered compact which comprises an aluminum nitride as the main ingredients exists in an interface with the thin film which constitutes a light emitting device, it is not homogeneous, the smooth nature of the surface of a substrate is also usually small if it is compared with sapphire, it is conjectured to be the big cause of the improvement in luminous efficiency that many of light which was emitted from the luminescence layer can advance into the sintered compact which comprises an aluminum nitride as the main ingredients that it is much more hard to produce reflection of the light which was emitted from the luminescence layer. Since what has comparatively high not less than 80% as optical transmissivity can manufacture even if linear optical permeability is low unlike a transparent body in the case of the sintered compact which comprises an aluminum nitride as the main ingredients, so much light which was emitted from the luminescence layer of the light emitting device which was entered into the such sintered compact which comprises an aluminum nitride [symbol] main ingredients penetrates this sintered compact which comprises an aluminum nitride as the main ingredients, and is emitted to the exterior of the light emitting device, it is surmised that that is also the cause by which luminous efficiency became high extremely if it is compared with the sapphire substrate.

The sizes of the outside of a light emitting device are about 0.05 mm square-10 mm square, usually about 0.1 mm square-3 mm square, and when the thickness of the thin film layer which constitutes a light emitting device is totaled, it is about 0.5 μm-50 μm, susually about 1 μm-20 μm as mentioned above.

Since it seems that the luminescence layer of a light emitting device is the shape of a plane, and the light which was emitted from this luminescence layer is irradiated to the substrate surface which faces each other perpendicularly in about 0.5 μm-50 μm distance, so it is the structure in which phenomena, such as total reflection, cannot be produced easily in the interface of a substrate and the thin film which constitutes a light emitting device originally, it also seems that it is the big factor by which the sintered compact which comprises an aluminum nitride as the main ingredients functions more effectively as a substrate.

Moreover, it also seems that it will be one of the factors that there is no decline of the luminous efficiency by the rise in heat of a device since it will be promptly emitted to the exterior of a light emitting device and the rise in heat of an element will be controlled even if a part of light is confined in the inside of a device and changes to thermal energy, since the thermal conductivity of the substrate using the sintered compact which comprises an aluminum nitride as the main ingredients is as large as 5 times to 10 times if it is compared with a sapphire substrate.

In this invention, as for the sintered compact which comprises an aluminum nitride as the main ingredients and is used as a substrate for producing the above-mentioned light emitting device, anything can be used if the thin film which comprises as the main ingredients at least one or more materials selected from a gallium nitride, an indium nitride, and an aluminum nitride and forms at least N type semiconductor layer, a luminescence layer, and P type semiconductor layer which are the constituent element of this light emitting device can be formed as a epitaxially grown single crystal.

If saying in other words, if it is what can form the epitaxially grown single crystal thin film which comprises as the main ingredients at least one or more materials selected from a gallium nitride, an indium nitride, and an aluminum nitride by the method described below, even if it is what kind of sintered compact which comprises an aluminum nitride as the main ingredients, it can be used as a substrate for producing a light emitting device.

That is, 1) it is the method of producing the light emitting device by laminating directly an epitaxially grown single crystal thin film which comprises as the main ingredients at least one or more materials selected from a gallium nitride, an indium nitride, and an aluminum nitride which constitutes a light emitting device as N type semiconductor layer, a luminescence layer, and P type semiconductor layer on the substrate which uses the sintered compact which comprises an aluminum nitride as the main ingredients as it is.

In this method, it is desirable that the buffer layer which consists of a thin film which comprises as the main ingredients at least one or more materials selected from a gallium nitride, an indium nitride, and an aluminum nitride is formed beforehand on a substrate, if it requires, then a light emitting device will be produced by laminating the N type semiconductor layer, luminescence layer, and P type semiconductor layer on it.

And, 2) it is the method of producing the light emitting device by laminating an epitaxially grown single crystal thin film which comprises as the main ingredients at least one or more materials selected from a gallium nitride, an indium nitride, and an aluminum nitride which constitutes a light emitting device as N type semiconductor layer, a luminescence layer, and P type semiconductor layer on the thin film substrate, after making the thin film substrate by beforehand forming at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., on the substrate which is produced from the sintered compact which comprises an aluminum nitride as the main ingredients.

When producing the light emitting device using the above-mentioned thin film substrate, it is also possible to use at least a part of thin film layer which is currently formed on this thin film substrate as a constituent factor for a light emitting device to function.

In this method, it is desirable that the buffer layer which consists of a thin film which comprises as the main ingredients at least one or more materials selected from a gallium nitride, an indium nitride, and an aluminum nitride is formed beforehand on a thin film substrate, if it requires, then a light emitting device will be produced by laminating the N type semiconductor layer, luminescence layer, and P type semiconductor layer on it.

And, 3) it is the method of producing the light emitting device by laminating an epitaxially grown single crystal thin film which comprises as the main ingredients at least one or more materials selected from a gallium nitride, an indium nitride, and an aluminum nitride which constitutes a light emitting device as N type semiconductor layer, a luminescence layer, and P type semiconductor layer on the thin film substrate, after making a thin film substrate by further forming at least one or more layers of single crystal thin films which comprise as the main ingredients at least one or more materials selected from a gallium nitride, an indium nitride, and an aluminum nitride on what formed beforehand at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., on the substrate which is produced from the sintered compact which comprises an aluminum nitride as the main ingredients.

When producing the light emitting device using the above-mentioned thin film substrate, it is also possible to use at least a part of thin film layer which is currently formed in this thin film substrate as a constituent factor for a light emitting device to function.

In this method, it is desirable that the buffer layer which consists of a thin film which comprises as the main ingredients at least one or more materials selected from a gallium nitride, an indium nitride, and an aluminum nitride is formed beforehand on a thin film substrate, if it requires, then a light emitting device will be produced by laminating the N type semiconductor layer, luminescence layer, and P type semiconductor layer on it.

Among the method shown in the above 1)-3), it is desirable when using what formed beforehand the thin film which comprises as the main ingredients at least one or more materials selected from a gallium nitride, an indium nitride, and an aluminum nitride and has at least one of crystal states selected from an amorphous state, a polycrystal, an orientated polycrystal, and a single crystal, etc. on the substrate which is made from the sintered compact which comprises an aluminum nitride as the main ingredients shown in 2)-3), as a substrate for thin film production produces the light emitting device which was excellent in luminous efficiency.

Usually, the light emitting device of luminous efficiency not less than 10% is producible by using such thin film substrate.

Moreover, if the thin film which is formed on a substrate which comprises as the main ingredients at least one or more materials selected from a gallium nitride, an indium nitride, and an aluminum nitride is made into at least two or more layers, and the substrate whose surface one is a single crystal among this thin films of two or more layers is used, since the light emitting device excellent in luminous efficiency can be easily produced on it regardless of the crystal state of the thin film formed beforehand on a substrate, it is desirable.

That is, when using the sintered compact which comprises an aluminum nitride as the main ingredients as a substrate, if the substrate in which at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., are formed beforehand on it and at least one or more layers of single crystal thin film which comprises as the main ingredients at least one or more materials selected from a gallium nitride, an indium nitride, and an aluminum nitride are formed furthermore on it is used, on it, the light emitting device of luminous efficiency not less than 12% can be produced easily.

Especially, when producing what has luminous efficiency not less than 15% as a light emitting device, or when producing a laser diode as a light emitting device, it is effective to use the thin film substrate in which the single crystal thin film was formed on such surface.

When producing the light emitting device by using the above-mentioned thin film substrate, it is also possible to use at least a part of thin film layer currently formed in this thin film substrate as a constituent factor for a light emitting device to function.

In this method, it is desirable to first form the buffer layer which consists of a thin film which comprises as the main ingredients at least one or more materials selected from a gallium nitride, an indium nitride, and an aluminum nitride, on a thin film substrate, if it requires, to laminate N type semiconductor layer, a luminescence layer, and P type semiconductor layer on it, and to produce a light emitting device.

When producing a light emitting device using the thin film substrate according to this invention, it is also possible to produce a light emitting device, without providing especially the above-mentioned buffer layer.

In this invention, as for quality, such as the crystallinity of the thin film which is formed on the substrate by using the sintered compact which has such characteristics and comprises an aluminum nitride as the main ingredients, etc., the relation with composition, purity, the content of an aluminum nitride ingredient, optical permeability, the size of a sintered compact crystal grain, and the existence of conduction via etc., of this sintered compact which comprises an aluminum nitride as the main ingredients, or the relation with the surface smooth nature, and the thickness of a substrate etc., when using as a substrate this sintered compact which comprises an aluminum nitride as the main ingredients, or the relation with the thin film constitution and thin film thickness, etc. which are formed in the substrate which consists of this sintered compact which comprises an aluminum nitride as the main ingredients has been explained until now.

In this invention, if it is what can form the single crystal thin film which comprises as the main ingredients at least one or more materials selected from a gallium nitride, an indium nitride, and an aluminum nitride as a sintered compact which comprises an aluminum nitride as the main ingredients, even if it is what has what kind of composition, the light emitting device which has excellent luminous efficiency can be produced by using as a substrate this sintered compact which comprises an aluminum nitride as the main ingredients.

Usually, the light emitting device which is equivalent at least or which has been improved to a maximum of not less than 4-5 times if it is compared with the luminous efficiency of the light emitting device produced by using the conventional substrates, such as sapphire etc., can be provided.

Usually, it is preferred to use as a substrate the sintered compact which contains an aluminum nitride ingredient not less than 20 volume % at least and comprises an aluminum nitride as the main ingredients, the light emitting device which is at least equivalent or which has been improved to a maximum of not less than 4-5 times can be produced if it is compared with the luminous efficiency of the light emitting device produced by using the conventional substrates, such as sapphire etc.

If it says in more detail, 1) in the case of the method of producing the light emitting device, such as, using the sintered compact which comprises an aluminum nitride as the main ingredients as a substrate as it is, if it requires, the buffer layer which consists of a thin film which comprises as the main ingredients at least one or more materials selected from a gallium nitride, an indium nitride, and an aluminum nitride will be first formed directly on it, and the epitaxially grown single crystal thin film which comprises as the main ingredients at least one or more materials selected from a gallium nitride, an indium nitride, and an aluminum nitride will be laminated on it as N type semiconductor layer, a luminescence layer, and P type semiconductor layer, usually, it is preferred to use the sintered compact which contains an aluminum nitride ingredient not less than 50 volume % and comprises an aluminum nitride as the main ingredients, and the light emitting device whose luminous efficiency is at least not less than 10% can be produced.

And, there are methods, such as, 2) the method of producing the light emitting device, such as, making the sintered compact which comprises an aluminum nitride as the main ingredients as a substrate, a thin film substrate will be made by beforehand forming at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., on it, if it requires, the buffer layer which consists of a thin film which comprises as the main ingredients at least one or more materials selected from a gallium nitride, an indium nitride, and an aluminum nitride will be first formed on it, and the epitaxially grown single crystal thin film which comprises as the main ingredients at least one or more materials selected from a gallium nitride, an indium nitride, and an aluminum nitride will be laminated on it as N type semiconductor layer, a luminescence layer, and P type semiconductor layer, and 3) in the case of the method of producing the light emitting device, such as, making the sintered compact which comprises an aluminum nitride as the main ingredients as a substrate, at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., will be formed beforehand on it, a thin film substrate will be made by forming furthermore at least one or more layers of single crystal thin films which comprise as the main ingredients at least one or more materials selected from a gallium nitride, an indium nitride, and an aluminum nitride on it, if it requires, the buffer layer which consists of a thin film which comprises as the main ingredients at least one or more materials selected from a gallium nitride, an indium nitride, and an aluminum nitride will be first formed on it, and the epitaxially grown single crystal thin film which comprises as the main ingredients at least one or more materials selected from a gallium nitride, an indium nitride, and an aluminum nitride will be laminated on it as N type semiconductor layer, a luminescence layer, and P type semiconductor layer, even when producing a light emitting device by the method explained in the above 2)-3), the light emitting device whose luminous efficiency is at least not less than 10% can be produced.

In the method shown in the above 1)-3), usually, it is preferred to use as a substrate the sintered compact which contains an aluminum nitride ingredient not less than 20 volume % and comprises an aluminum nitride as the main ingredients, the light emitting device whose luminous efficiency is at least not less than 10% can be produced.

When using as a substrate the sintered compact which contains an aluminum nitride ingredient not less than 20 volume % and comprises an aluminum nitride as the main ingredients, usually, it is preferred to use the substrate in which the thin film which has at least one of the crystallized states selected from an amorphous state, a polycrystal, and an orientated polycrystal and which comprises as the main ingredients at least one or more materials selected from a gallium nitride, an indium nitride, and an aluminum nitride was formed beforehand on this substrate.

When using as a substrate the sintered compact which contains an aluminum nitride ingredient not less than 20 volume % and comprises an aluminum nitride as the main ingredients, if the thin film which is formed beforehand on this substrate and comprises as the main ingredients at least one or more materials selected from a gallium nitride, an indium nitride, and an aluminum nitride has the crystallized state of an orientated polycrystal, the light emitting device whose luminous efficiency is at least not less than 12% can be produced on it.

Moreover, when using as a substrate the sintered compact which contains an aluminum nitride ingredient not less than 20 volume % and comprises an aluminum nitride as the main ingredients, if at least two or more layers of the thin films which comprise as the main ingredients at least one or more materials selected from a gallium nitride, an indium nitride, and an aluminum nitride are formed, and a surface one is a single crystal among this thin film of two or more layers, regardless of the crystallized states of the thin film formed beforehand in a substrate, the light emitting device whose luminous efficiency is at least not less than 12% can be produced on it.

That is, when using as a substrate the sintered compact which contains an aluminum nitride ingredient not less than 20 volume % and comprises an aluminum nitride as the main ingredients, if at least one or more layers of thin films which have at least one of the crystallized states selected from an amorphous state, a polycrystal, and an orientated polycrystal and which comprise as the main ingredients at least one or more materials selected from a gallium nitride, an indium nitride, and an aluminum nitride are formed beforehand on it, and a thin film substrate in which at least one or more layers of single crystal thin films which comprise as the main ingredients at least one or more materials selected from a gallium nitride, an indium nitride, and an aluminum nitride are formed furthermore on it is used, the light emitting device whose luminous efficiency is at least not less than 12% can be produced on it.

Moreover, although it can be used as a substrate for light emitting device production as it is when using the sintered compact which comprises an aluminum nitride as the main ingredients as a substrate and contains an aluminum nitride ingredient not less than 50 volume %, usually, it is preferred to use that whose thin film which comprises as the main ingredients at least one or more materials selected from a gallium nitride, an indium nitride, and an aluminum nitride and which has at least one of the crystallized states selected from a single crystal, an amorphous state, a polycrystal, and an orientated polycrystal was formed beforehand on this substrate.

When using as a substrate the sintered compact which comprises an aluminum nitride as the main ingredients and contains an aluminum nitride ingredient not less than 50 volume %, if the thin film which comprises as the main ingredients at least one or more materials selected from a gallium nitride, an indium nitride, and an aluminum nitride is what has at least one of the crystallized states selected from an amorphous state, a polycrystal, and an orientated polycrystal, the light emitting device whose luminous efficiency is at least not less than 12% can be produced on it.

Moreover, when using as a substrate the sintered compact which comprises an aluminum nitride as the main ingredients and contains an aluminum nitride ingredient not less than 50 volume %, if the thin film which comprises as the main ingredients at least one or more materials selected from a gallium nitride, an indium nitride, and an aluminum nitride is what has crystallized state of an orientated polycrystal, the light emitting device whose luminous efficiency is at least not less than 15% can be produced on it.

Moreover, when using as a substrate the sintered compact which comprises an aluminum nitride as the main ingredients and contains an aluminum nitride ingredient not less than 50 volume %, if at least two or more layers of the thin films which comprise as the main ingredients at least one or more materials selected from a gallium nitride, an indium nitride, and an aluminum nitride are formed, and a surface one is a single crystal among this thin film of two or more layers, regardless of the crystallized states of the thin film formed beforehand on a substrate, the light emitting device whose luminous efficiency is at least not less than 15% can be produced on it.

That is, when using as a substrate the sintered compact which comprises an aluminum nitride as the main ingredients and contains an aluminum nitride ingredient not less than 50 volume %, if at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., are formed beforehand on it, and a substrate in which at least one or more layers of single crystal thin films which comprise as the main ingredients at least one or more materials selected from a gallium nitride, an indium nitride, and an aluminum nitride are formed furthermore on it is used, the light emitting device whose luminous efficiency is at least not less than 15% can be produced on it.

Especially when producing the thing whose luminous efficiency is at least not less than 20% as a light emitting device, or when producing a laser diode as a light emitting device, it is effective to use the substrate in which the single crystal thin film was formed on such surface.

In this invention, the light emitting device which has excellent luminous efficiency can be produced even if the sintered compact which comprises an aluminum nitride as the main ingredients and which is the optical transmissivity smaller than 1% or does not have optical permeability substantially are used as a substrate.

Moreover, the light emitting device which has excellent luminous efficiency can be produced even if the sintered compact of optical transmissivity not less than 1% which comprises an aluminum nitride as the main ingredients and which has optical permeability is also used as a substrate.

Usually, by using the above-mentioned sintered compact which comprises an aluminum nitride as the main ingredients as a substrate, the light emitting device which is at least equivalent or which has been improved to a maximum of not less than 4-5 times can be provided if it is compared with the luminous efficiency of the light emitting device produced by using the conventional substrates, such as sapphire etc.

If it says in more detail, if the sintered compact which comprises an aluminum nitride as the main ingredients and which has the optical transmissivity smaller than 1% or does not have optical permeability substantially, or the sintered compact which comprises an aluminum nitride as the main ingredients and which has the optical transmissivity not less than 1%, are used as a substrate, the light emitting device whose luminous efficiency is at least not less than 10% can produce.

Usually, as for the sintered compact which comprises an aluminum nitride as the main ingredients, if what has higher optical permeability is used as a substrate, since a light emitting device with higher luminous efficiency is producible, it is desirable.

That is, when the sintered compact of optical transmissivity not less than 10% which comprises an aluminum nitride as the main ingredients is used as a substrate, since what is not less than 12% as luminous efficiency of the light emitting device formed on it is easy to be obtained, it is preferred.

And, when the sintered compact of optical transmissivity not less than 20% which comprises an aluminum nitride as the main ingredients is used as a substrate, what is not less than 15% as luminous efficiency of the light emitting device formed on it is easy to be obtained.

And, when the sintered compact of optical transmissivity not less than 30% which comprises an aluminum nitride as the main ingredients is used as a substrate, what is not less than 20% as luminous efficiency of the light emitting device formed on it is easy to be obtained.

And, when the sintered compact of optical transmissivity not less than 40% which comprises an aluminum nitride as the main ingredients is used as a substrate, what is not less than 25% as luminous efficiency of the light emitting device formed on it is easy to be obtained.

And, when the sintered compact of optical transmissivity not less than 50% which comprises an aluminum nitride as the main ingredients is used as a substrate, what is not less than 30% as luminous efficiency of the light emitting device formed on it is easy to be obtained.

In this invention, as mentioned above, what is the optical transmissivity not less than 60% is obtained, and further what is a maximum of not less than 80% is also obtained, when the sintered compact which comprises an aluminum nitride as the main ingredients and which has such high optical transmissivity was used as a substrate, what is not less than 40% and a maximum of 62% as luminous efficiency of the light emitting device formed on it were obtained.

Thus, since what is at least not less than 10% is easy to be obtained as luminous efficiency of the light emitting device produced by using the sintered compact which comprises an aluminum nitride as the main ingredients as a substrate, the light emitting device which is at least equivalent or which has been improved to a maximum of not less than 4-5 times can be provided if it is compared with the luminous efficiency of the light emitting device produced by using the conventional substrates, such as sapphire etc.

In this invention, if it is what can form the single crystal thin film which comprises as the main ingredients at least one or more materials selected from a gallium nitride, an indium nitride, and an aluminum nitride as a sintered compact which comprises an aluminum nitride as the main ingredients, even if the aluminum nitride crystal grain in this sintered compact is what has what kind of size, the light emitting device which has excellent luminous efficiency can produce by using as a substrate this sintered compact which comprises an aluminum nitride as the main ingredients.

Usually, the light emitting device which is at least equivalent or which has been improved to a maximum of not less than 4-5 times can be provided if it is compared with the luminous efficiency of the light emitting device produced by using the conventional substrates, such as sapphire etc.

Usually, it is preferred to use as a substrate the sintered compact which comprises an aluminum nitride as the main ingredients and has the aluminum nitride crystal grain whose size is an average of not less than 0.5 μm, the light emitting device which is at least equivalent or which has been improved to a maximum of not less than 4-5 times can be produced if it is compared with the luminous efficiency of the light emitting device produced by using the conventional substrates, such as sapphire etc.

If saying in more detail, if the sintered compact which comprises an aluminum nitride as the main ingredients and has the aluminum nitride crystal grain whose size is an average of not less than 1.0 μm is used as a substrate, the light emitting device whose luminous efficiency is at least not less than 10% can be produced.

Moreover, even if it uses as a substrate the sintered compact which comprises an aluminum nitride as the main ingredients and which has not only what is the state where the included crystal grain is equal to the equally near size but also what has the irregular size of a crystal grain, or the crystal grain of distorted form whose one side is small and whose other one side is large, such as the needlelike or boardlike shape, for example, such as a poly type AlN particle, the crystal grain of form whose one side grew up into several μm and whose other one side grew up into about ten or more μm greatly, such as needlelike or the shape of a board, the light emitting device excellent in luminous efficiency is producible satisfactorily at all.

In addition, even if it uses what formed the conduction via in the sintered compact which comprises an aluminum nitride as the main ingredients as a substrate, the single crystal thin film which comprises as the main ingredients at least one or more materials selected from a gallium nitride, an indium nitride, and an aluminum nitride can be formed, so the light emitting device which has excellent luminous efficiency can produce.

It is possible to use anything, if it is the material which has conductivity as a conduction via.

Usually, the material which comprises as the main ingredients a metal, an alloy, or a metal compound, such as tungsten, molybdenum, gold, silver, copper, and titanium nitride, as a material of a conduction via is used.

If the sintered compact which comprises an aluminum nitride as the main ingredients and formed the conduction via which consists of such material is used as a substrate, the light emitting device which is equivalent at least or has the luminous efficiency improved to a maximum of not less than 4-5 times can be provided if it is compared with the luminous efficiency of the light emitting device produced by using the conventional substrates, such as sapphire etc.

If it says in more detail, the light emitting device whose luminous efficiency is at least not less than 10% can be produced by using as a substrate what formed the conduction via in the sintered compact which comprises an aluminum nitride as the main ingredients.

As mentioned above, it explained that it is effective to use the sintered compact which comprises an aluminum nitride as the main ingredients as a substrate for making a light emitting device, and that especially if it is what has optical permeability, the light emitting device which is more excellent in luminous efficiency is producible.

And in this invention, even if it is what is in what kind of state as surface smooth nature of the substrate which consists of a sintered compact which comprises an aluminum nitride as the main ingredients, if it is what can form the single crystal thin film which comprises as the main ingredients at least one or more materials selected from a gallium nitride, an indium nitride, and an aluminum nitride, what has excellent luminous efficiency can be produced as the light emitting device which is formed on this substrate which consists of a sintered compact which comprises an aluminum nitride as the main ingredients.

Usually, as for the luminous efficiency of a light emitting device produced by using the substrate which consists of a sintered compact which has the above-mentioned surface smooth nature and comprises an aluminum nitride as the main ingredients, what is at least equivalent if it is compared with the luminous efficiency of the light emitting device produced by using conventional substrates, such as sapphire etc., or what has been improved to a maximum of not less than 4-5 times can be provided.

If it says in more detail, 1) in the case of the method of producing the light emitting device, such as, using the sintered compact which comprises an aluminum nitride as the main ingredients as a substrate as it is, if it requires, the buffer layer which consists of a thin film which comprises as the main ingredients at least one or more materials selected from a gallium nitride, an indium nitride, and an aluminum nitride will be first formed directly on it, and the epitaxially grown single crystal thin film which comprises as the main ingredients at least one or more materials selected from a gallium nitride, an indium nitride, and an aluminum nitride will be laminated on it as N type semiconductor layer, a luminescence layer, and P type semiconductor layer, usually, the light emitting device whose luminous efficiency is at least not less than 10% can be produced by using what is not more than 2000 nm as average surface roughness Ra of the substrate which consists of a sintered compact which comprises an aluminum nitride as the main ingredients.

And, there are methods, such as, 2) the method of producing the light emitting device, such as, making the sintered compact which comprises an aluminum nitride as the main ingredients as a substrate, a thin film substrate will be made by beforehand forming at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., on it, if it requires, the buffer layer which consists of a thin film which comprises as the main ingredients at least one or more materials selected from a gallium nitride, an indium nitride, and an aluminum nitride will be first formed on it, and the epitaxially grown single crystal thin film which comprises as the main ingredients at least one or more materials selected from a gallium nitride, an indium nitride, and an aluminum nitride will be laminated on it as N type semiconductor layer, a luminescence layer, and P type semiconductor layer, and 3) the method of producing the light emitting device, such as, making the sintered compact which comprises an aluminum nitride as the main ingredients as a substrate, at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., will be formed beforehand on it, a thin film substrate will be made by forming furthermore at least one or more layers of single crystal thin films which comprise as the main ingredients at least one or more materials selected from a gallium nitride, an indium nitride, and an aluminum nitride on it, if it requires, the buffer layer which consists of a thin film which comprises as the main ingredients at least one or more materials selected from a gallium nitride, an indium nitride, and an aluminum nitride will be first formed on this thin film substrate, and the epitaxially grown single crystal thin film which comprises as the main ingredients at least one or more materials selected from a gallium nitride, an indium nitride, and an aluminum nitride will be laminated on it as N type semiconductor layer, a luminescence layer, and P type semiconductor layer, when producing a light emitting device by the method explained in the above 2)-3), usually, even if what is more than 2000 nm as average surface roughness Ra of the substrate which consists of a sintered compact which comprises an aluminum nitride as the main ingredients is used, the light emitting device whose luminous efficiency is at least not less than 10% can be produced.

In this invention, even if the thickness of the substrate which consists of a sintered compact which comprises an aluminum nitride as the main ingredients is what kind of thing, if it is what can form the single crystal thin film which comprises as the main ingredients at least one or more materials selected from a gallium nitride, an indium nitride, and an aluminum nitride, what has excellent luminous efficiency can be produced as the light emitting device which is formed on this substrate which consists of a sintered compact which comprises an aluminum nitride as the main ingredients.

Usually, as for the luminous efficiency of the light emitting device produced by using the substrate which consists of a sintered compact which has the above-mentioned thickness of the substrate and comprises an aluminum nitride as the main ingredients, what is at least equivalent if it is compared with the luminous efficiency of the light emitting device produced by using conventional substrates, such as sapphire etc., or what has been improved to a maximum of not less than 4-5 times can be provided.

Usually, the light emitting device whose luminous efficiency is at least not less than 10% can be produced by using what has not more than 8.0 mm as the thickness of the substrate which consists of a sintered compact which comprises an aluminum nitride as the main ingredients.

In the above, it is effective to use the sintered compact which comprises an aluminum nitride as the main ingredients as a substrate for making a light emitting device, the effect of purity (composition), optical transmissivity, a sintered compact crystal grain, the existence of a conduction via, surface smooth nature as a substrate, and thickness as a substrate, etc., have been explained about this sintered compact which comprises an aluminum nitride as the main ingredients.

As explained above, a) the method of producing the light emitting device, such as, making the sintered compact which comprises an aluminum nitride as the main ingredients as a substrate, a thin film substrate will be made by beforehand forming at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., on it, then N type semiconductor layer, a luminescence layer, and P type semiconductor layer will be laminated on this thin film substrate, and b) the method of producing the light emitting device, such as, making the sintered compact which comprises an aluminum nitride as the main ingredients as a substrate, at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., will be formed beforehand on it, a thin film substrate will be made by forming furthermore at least one or more layers of single crystal thin films which comprise as the main ingredients at least one or more materials selected from a gallium nitride, an indium nitride, and an aluminum nitride on it, then N type semiconductor layer, a luminescence layer, and P type semiconductor layer will be laminated on this thin film substrate, when producing a light emitting device by the method explained in the above a), b), in the case of that whose thin film which comprises as the main ingredients at least one or more materials selected from a gallium nitride, an indium nitride, and an aluminum nitride and is formed beforehand on the substrate which consists of a sintered compact which comprises an aluminum nitride as the main ingredients is what has at least one of the crystallized states selected from a single crystal, an amorphous state, a polycrystal, and an orientated polycrystal, unless reference is made especially, on it, the light emitting device of luminous efficiency not less than 10% can usually produce.

Among the above-mentioned thin film which is formed beforehand on the substrate and comprises as the main ingredients at least one or more materials selected from a gallium nitride, an indium nitride, and an aluminum nitride, what has at least one of the crystallized states selected from an amorphous state, a polycrystal, and an orientated polycrystal is more preferred.

Moreover, when it is the thing whose thin film which is formed beforehand on the substrate and comprises as the main ingredients at least one or more materials selected from a gallium nitride, an indium nitride, and an aluminum nitride has the crystallized state of an orientated polycrystal, unless reference is made especially, on it, the light emitting device of luminous efficiency not less than 12% can be usually produced.

And, if at least two or more layers of the thin films which comprise as the main ingredients at least one or more materials selected from a gallium nitride, an indium nitride, and an aluminum nitride are made, and a surface one is a single crystal among this thin film of two or more layers, regardless of the crystallized states of the thin film formed beforehand on a substrate, the light emitting device which has luminous efficiency at least not less than 12% can be produced on it.

In this invention, by using as a substrate not only the above-mentioned substrate which consists of a sintered compact which comprises an aluminum nitride as the main ingredients but also the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., if it requires, the buffer layer which consists of a thin film which comprises as the main ingredients at least one or more materials selected from a gallium nitride, an indium nitride, and an aluminum nitride will be formed first on this substrate, and the epitaxially grown single crystal thin film which comprises as the main ingredients at least one or more materials selected from a gallium nitride, an indium nitride, and an aluminum nitride will be laminated on it as N type semiconductor layer, a luminescence layer, and P type semiconductor layer, then a light emitting device is producible.

In this invention, there is the feature in having constituted the light emitting device by having laminated the above-mentioned N type semiconductor layer, the luminescence layer, and P type semiconductor layer at least onto the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., or onto this sintered compact made into the shape of a substrate.

The light emitting device produced by using as a substrate the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., can also produce the thing excellent in luminous efficiency.

That is, using the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., the light emitting device which is at least equivalent or which has been improved to a maximum of not less than 3-4 times can be provided if it is compared with the luminous efficiency of the light emitting device produced using the conventional single crystal substrates, such as sapphire etc.

That is, in the light emitting device which is produced using the substrate according to this invention which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., a maximum of not less than 20-30% of the inputted electric power can be emitted to the exterior of a light emitting device as optical energy.

Although it is not necessarily clear about the cause in which a light emitting device according to this invention produced using the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., has high luminous efficiency, it is certain that it is that a single crystal thin film excellent in such crystallinity can be used now as at least N type semiconductor layer, a luminescence layer, and P type semiconductor layer of a light emitting device is important for the first.

However, not only that but it is, as for the above-mentioned substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., as a cause of having the luminous efficiency more than equal to conventional single crystal substrates, such as a sapphire etc., it seems that it is still more important that it is not a bulk single crystal like sapphire but has a microstructure as a sintered compact which is sintered and is constituted with a crystal grain and a grain boundary phase etc. as well as the substrate which consists of a sintered compact which comprises an aluminum nitride as the main ingredients.

As mentioned above, a single crystal thin film which has the crystallinity not more than 300 seconds at least as half width of the rocking curve of the X ray diffraction line from the lattice plane of a Miller Index (002) and comprises as the main ingredients at least one or more materials selected from a gallium nitride, an indium nitride, and an aluminum nitride can be formed also on a sapphire substrate, and a light emitting device has been manufactured by forming such single crystal thin film which is excellent in crystallinity and is constituted with each layer of N type semiconductor layer, luminescence layer, and P type semiconductor layer at least, onto a sapphire substrate.

As for a light emitting device produced using the substrate according to this invention which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., the light emitting device which is at least equivalent or which has been improved to a maximum of not less than 3-4 times can be provided if it is compared with the luminous efficiency of the light emitting device produced using the above-mentioned single crystal substrates, such as sapphire etc.

That is, what has luminous efficiency at least not less than 8% can be produced as a light emitting device produced using the substrate according to this invention which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

In this invention, as the above-mentioned various sintered compacts which are used as a substrate for producing the light emitting device and comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., anything can be used if the thin film which comprises as the main ingredients at least one or more materials selected from a gallium nitride, an indium nitride, and an aluminum nitride and which forms at least N type semiconductor layer, a luminescence layer, and P type semiconductor layer which are the constituent factor of this light emitting device can be formed as a single crystal which grew epitaxially.

If saying in other words, if it is what can form the epitaxially grown single crystal thin film which comprises as the main ingredients at least one or more materials selected from a gallium nitride, an indium nitride, and an aluminum nitride by the method described below, even if it is what kind of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., it can be used as a substrate for producing a light emitting device.

That is, 1) it is the method of producing the light emitting device by laminating directly an epitaxially grown single crystal thin film which comprises as the main ingredients at least one or more materials selected from a gallium nitride, an indium nitride, and an aluminum nitride which constitutes a light emitting device as N type semiconductor layer, a luminescence layer, and P type semiconductor layer onto the substrate which uses the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., as it is.

In this method, it is desirable that the buffer layer which consists of a thin film which comprises as the main ingredients at least one or more materials selected from a gallium nitride, an indium nitride, and an aluminum nitride is formed beforehand on a substrate, if it requires, then a light emitting device will be produced by laminating the N type semiconductor layer, luminescence layer, and P type semiconductor layer on it.

And, 2) it is the method of producing the light emitting device, such as, making as a substrate the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., a thin film substrate will be made by beforehand forming at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., on this substrate, and the epitaxially grown single crystal thin film which comprises as the main ingredients at least one or more materials selected from a gallium nitride, an indium nitride, and an aluminum nitride will be laminated on it as N type semiconductor layer, a luminescence layer, and P type semiconductor layer,

When producing the light emitting device by using the above-mentioned thin film substrate, it is also possible to use at least a part of thin film layer currently formed in this thin film substrate as a constituent factor for a light emitting device to function.

In this method, it is desirable that the buffer layer which consists of a thin film which comprises as the main ingredients at least one or more materials selected from a gallium nitride, an indium nitride, and an aluminum nitride is formed beforehand on the above-mentioned thin film substrate, if it requires, then a light emitting device will be produced by laminating the N type semiconductor layer, luminescence layer, and P type semiconductor layer on it.

And, 3) it is the method of producing the light emitting device, such as, making as a substrate the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., will be formed beforehand on this substrate, a thin film substrate will be made by forming furthermore at least one or more layers of single crystal thin films which comprise as the main ingredients at least one or more materials selected from a gallium nitride, an indium nitride, and an aluminum nitride on it, and the epitaxially grown single crystal thin film which comprises as the main ingredients at least one or more materials selected from a gallium nitride, an indium nitride, and an aluminum nitride will be laminated on it as N type semiconductor layer, a luminescence layer, and P type semiconductor layer.

When producing the light emitting device by using the above-mentioned thin film substrate, it is also possible to use at least a part of thin film layer currently formed in this thin film substrate as a constituent factor for a light emitting device to function.

In this method, it is desirable that the buffer layer which consists of a thin film which comprises as the main ingredients at least one or more materials selected from a gallium nitride, an indium nitride, and an aluminum nitride is formed beforehand on the above-mentioned thin film substrate, if it requires, then a light emitting device will be produced by laminating the N type semiconductor layer, luminescence layer, and P type semiconductor layer on it.

According to the method explained in the above 1)-3), a light emitting device of luminous efficiency not less than 8% can be produced easily using the various sintered compacts according to this invention which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., as a substrate for light emitting device production

In the method explained in the above 1)-3), if the thin film which is formed on a substrate which comprises as the main ingredients at least one or more materials selected from a gallium nitride, an indium nitride, and an aluminum nitride is made into at least two or more layers, and the substrate whose surface thin film is a single crystal among this thin films of two or more layers is used, since the light emitting device excellent in luminous efficiency can be easily produced on it regardless of the crystal state of the thin film formed beforehand on a substrate, it is desirable.

That is, when using as a substrate the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., if at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., are formed beforehand on it, and a substrate in which at least one or more layers of single crystal thin films which comprise as the main ingredients at least one or more materials selected from a gallium nitride, an indium nitride, and an aluminum nitride are formed furthermore on it is used, the light emitting device which has luminous efficiency at least not less than 10% can be produced on it.

Especially, when producing what is luminous efficiency not less than 12% as a light emitting device, or when producing a laser diode as a light emitting device, it is effective to use the substrate in which the single crystal thin film was formed on such surface.

When producing the light emitting device by using the above-mentioned thin film substrate, it is also possible to use at least a part of thin film layer currently formed in this thin film substrate as a constituent factor for a light emitting device to function.

In this method, it is desirable that the buffer layer which consists of a thin film which comprises as the main ingredients at least one or more materials selected from a gallium nitride, an indium nitride, and an aluminum nitride is formed beforehand on the thin film substrate, if it requires, then a light emitting device will be produced by laminating the N type semiconductor layer, luminescence layer, and P type semiconductor layer on it.

And, when producing a light emitting device using the thin film substrate according to this invention, it is also possible to produce a light emitting device, without providing especially the above-mentioned buffer layer.

In this invention, as for a quality, such as the crystallinity of the thin film which is formed on the substrate using the various sintered compacts which have such characteristics and comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., the relation with composition, purity, content of an aluminum nitride ingredient, optical permeability, size of a sintered compact crystal grain, and existence of conduction via, etc. of these various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., or the relation with the surface smooth nature, etc. when using as a substrate these various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., or the relation with a thin film constitution, and thin film thickness, etc. which are formed on the substrate which consists of these various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., have been explained until now.

In this invention, if it is what can form the single crystal thin film which comprises as the main ingredients at least one or more materials selected from a gallium nitride, an indium nitride, and an aluminum nitride as various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., even if it is what has what kind of composition, the light emitting device which has excellent luminous efficiency can be produced using as a substrate these various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

Usually, the light emitting device which is at least equivalent or which has been improved to a maximum of not less than 3-4 times can be provided if it is compared with the luminous efficiency of the light emitting device produced by using the conventional substrates, such as sapphire etc.

If it says concretely, as composition of the sintered compact which comprises a silicon carbide as the main ingredients, for example, there is what consists only of SiC substantially, or a carbon ingredient, or a boron ingredient, such as B, B4C, and BN, etc., or a rare earth element ingredient, such as Y₂O₃, Er₂O₃, and Yb₂O₃, etc., or an alkaline-earth-metals ingredient, such as BeO, MgO, CaO, SrO, and BaO, etc., or aluminum ingredient, such as Al₂O₃, etc., or silicon ingredient, such as SiO₂, etc., or what contains one of these ingredients or what contains two or more.

As composition of the sintered compact which comprises a silicon nitride as the main ingredients, there is what consists only of Si₃N₄ substantially, or rare earth element ingredients, such as Y₂O₃, Er₂O₃, and Yb₂O₃, etc., or alkaline-earth-metals ingredients, such as BeO, MgO, CaO, SrO, and BaO, etc., or aluminum ingredients, such as Al₂O₃, etc., or silicon ingredients, such as SiO₂, etc., or black-ized promotion ingredients, such as carbon, molybdenum, and tungsten, etc., or transition metal ingredients, such as TiO₂, Cr₂O₃, MnO, CoO, NiO, Fe₂O₃, etc., or what contains one of these ingredients or what contains two or more.

As composition of the sintered compact which comprises a zinc oxide as the main ingredients, there is what consists only of ZnO substantially, or rare earth element ingredients, such as Y₂O₃, Er₂O₃, and Yb₂O₃, etc., or alkaline-earth-metals ingredients, such as BeO, MgO, CaO, SrO, and BaO, etc., or aluminum ingredients, such as Al₂O₃, etc., or silicon ingredients, such as SiO₂, etc., or transition metal ingredients, such as TiO₂, Cr₂O₃, MnO, CoO, NiO, Fe₂O₃, etc., or what contains one of these ingredients or what contains two or more.

As composition of the sintered compact which comprises a beryllium oxide as the main ingredients, there is what consists only of BeO substantially, or rare earth element ingredients, such as Y₂O₃, Er₂O₃, and Yb₂O₃, etc., or alkaline-earth-metals ingredients, such as BeO, MgO, CaO, SrO, and BaO, etc., or aluminum ingredients, such as Al₂O₃, etc., or silicon ingredients, such as SiO₂, etc., or transition metal ingredients, such as TiO₂, Cr₂O₃, MnO, CoO, NiO, Fe₂O₃, etc., or what contains one of these ingredients or what contains two or more.

As composition of the sintered compact which comprises an aluminum oxide as the main ingredients, there is what consists only of Al₂O₃ substantially, or rare earth element ingredients, such as Y₂O₃, Er₂O₃, and Yb₂O₃, etc., or alkaline-earth-metals ingredients, such as BeO, MgO, CaO, SrO, and BaO, etc., or aluminum ingredients, such as Al₂O₃, etc., or silicon ingredients, such as SiO₂, etc., or transition metal ingredients, such as TiO₂, Cr₂O₃, MnO, CoO, NiO, Fe₂O₃, etc., or what contains one of these ingredients or what contains two or more.

If it says in more detail, usually, it is desirable to use the sintered compact which comprises a zinc oxide as the main ingredients and contains a zinc oxide ingredient not less than 55.0 mol % by ZnO conversion, if this sintered compact which comprises a zinc oxide as the main ingredients is used as a substrate, the light emitting device whose luminous efficiency is at least not less than 8% can be produced.

As ingredients other than the above-mentioned zinc oxide, for example, there is the sintered compact which comprises a zinc oxide as the main ingredients and contains an aluminum ingredient not more than 45.0 mol % by Al₂O₃ conversion, or the sintered compact which comprises a zinc oxide as the main ingredients and contains an aluminum ingredient not more than 45.0 mol % by Al₂O₃ conversion and contains simultaneously at least one or more ingredients selected from a rare earth element ingredient, such as Sc, Y, La, Ce, Pr, Nd, Pm, Sm, Eu, Gd, Tb, Dy, Ho, Er, Tm, Yb, and Lu, etc. not more than 10.0 mol % by oxide conversion, if the substrate which consists of these sintered compacts is used, the light emitting device whose luminous efficiency is at least not less than 8% can be produced.

And, usually, it is desirable to use the sintered compact which comprises a beryllium oxide as the main ingredients and contains a beryllium oxide ingredient not less than 65.0 mol % by BeO conversion, if this sintered compact which comprises a beryllium oxide as the main ingredients is used as a substrate, the light emitting device whose luminous efficiency is at least not less than 8% can be produced.

As ingredients other than the above-mentioned beryllium oxide, for example, there is the sintered compact which comprises a beryllium oxide as the main ingredients and contains at least one or more ingredients selected from a magnesium ingredient, a calcium ingredient, and a silicon ingredient a total of not more than 35.0 mol % by MgO, CaO, and SiO₂ conversion, or the sintered compact which comprises a beryllium oxide as the main ingredients and which contains at least one or more ingredients selected from a magnesium ingredient, a calcium ingredient, and a silicon ingredient a total of not more than 35.0 mol % by MgO, CaO, and SiO₂ conversion and contains simultaneously not more than 5.0 mol % of at least one or more ingredients selected from rare earth element ingredients, such as Sc, Y, La, Ce, Pr, Nd, Pm, Sm, Eu, Gd, Tb, Dy, Ho, Er, Tm, Yb, and Lu, etc. by oxide conversion, if the substrate which consists of these sintered compacts is used, the light emitting device whose luminous efficiency is at least not less than 8% can be produced.

And, usually, it is desirable to use the sintered compact which comprises an aluminum oxide as the main ingredients and contains an aluminum oxide ingredient not less than 55.0 mol % by Al₂O₃ conversion, if this sintered compact which comprises an aluminum oxide as the main ingredients is used as a substrate, the light emitting device whose luminous efficiency is at least not less than 8% can be produced.

As ingredients other than the above-mentioned aluminum oxide, for example, there is the sintered compact which comprises an aluminum oxide as the main ingredients and contains at least one or more ingredients selected from a magnesium ingredient, a calcium ingredient, and a silicon ingredient a total of not more than 45.0 mol % by MgO, CaO, and SiO₂ conversion, or the sintered compact which comprises an aluminum oxide as the main ingredients and contains at least one or more ingredients selected from a magnesium ingredient, a calcium ingredient, and a silicon ingredient a total of not more than 45.0 mol % by MgO, CaO, and SiO₂ conversion and contains simultaneously at least one or more ingredients selected from a rare earth element ingredient, such as Sc, Y, La, Ce, Pr, Nd, Pm, Sm, Eu, Gd, Tb, Dy, Ho, Er, Tm, Yb, and Lu, etc. not more than 10.0 mol % by oxide conversion, or the sintered compact which contains at least one or more ingredients selected from a magnesium ingredient, a calcium ingredient, and a silicon ingredient a total of not more than 45.0 mol % by MgO, CaO, and SiO₂ conversion and contains simultaneously at least two or more ingredients selected from a rare earth element ingredient, such as Sc, Y, La, Ce, Pr, Nd, Pm, Sm, Eu, Gd, Tb, Dy, Ho, Er, Tm, Yb, and Lu, etc. not more than 10.0 mol % by oxide conversion, if the substrate which consists of these sintered compacts is used, the light emitting device whose luminous efficiency is at least not less than 8% can be produced.

In this invention, the light emitting device which has excellent luminous efficiency is producible even if the various sintered compacts in which the optical transmissivity is smaller than 1% or do not have optical permeability substantially and which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., are used as a substrate.

Moreover, the light emitting device which has excellent luminous efficiency can also be produced if the various sintered compacts which are the optical transmissivity not less than 1% and have optical permeability and which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., are used as a substrate.

Usually, using as a substrate the above-mentioned various sintered compacts which comprise as the main ingredients a ceramic material which has the crystal structure which can be classified-as a hexagonal system, such as a silicon carbide, a silicon nitride, a zinc oxide, and a beryllium oxide etc., and classified as a trigonal system or a hexagonal system, such as an aluminum oxide etc., the light emitting device which is at least equivalent or which has been improved to a maximum of not less than 3-4 times can be provide if it is compared with the luminous efficiency of the light emitting device produced using the conventional substrates, such as sapphire etc.

If it says in more detail, if the sintered compact which comprises a zinc oxide as the main ingredients and which has the optical transmissivity smaller than 1% or does not have optical permeability substantially, or the sintered compact which comprises a zinc oxide as the main ingredients and which has the optical transmissivity not less than 1%, are used as a substrate, the light emitting device whose luminous efficiency is at least not less than 8% is producible.

Usually, as for the sintered compact which comprises a zinc oxide as the main ingredients, if what has high optical permeability is used as a substrate a light emitting device with higher luminous efficiency is producible, it is desirable.

That is, when the sintered compact of optical transmissivity not less than 10% which comprises a zinc oxide as the main ingredients is used as a substrate, what is not less than 10% as luminous efficiency of the light emitting device formed on it is easy to be obtained.

Moreover, when the sintered compact of optical transmissivity not less than 20% which comprises a zinc oxide as the main ingredients is used as a substrate, since what is not less than 12% as luminous efficiency of the light emitting device formed on it is easy to be obtained, it is desirable.

Moreover, when the sintered compact of optical transmissivity not less than 30% which comprises a zinc oxide as the main ingredients is used as a substrate, what is not less than 15% as luminous efficiency of the light emitting device formed on it is easy to be obtained.

Moreover, when the sintered compact of optical transmissivity not less than 40% which comprises a zinc oxide as the main ingredients is used as a substrate, what is not less than 20% as luminous efficiency of the light emitting device formed on it is easy to be obtained.

Moreover, when the sintered compact of optical transmissivity not less than 50% which comprises a zinc oxide as the main ingredients is used as a substrate, what is not less than 25% as luminous efficiency of the light emitting device formed on it is easy to be obtained.

In this invention, as mentioned above, what is not less than 60% is obtained as optical transmissivity, and further what is a maximum of not less than 80% is also obtained, when the sintered compact which has such high optical transmissivity and which comprises a zinc oxide as the main ingredients was used as a substrate, what is not less than 30% and a maximum of 55% as luminous efficiency of the light emitting device which are formed on it were obtained.

Moreover, if the sintered compact which comprises a beryllium oxide as the main ingredients and which has the optical transmissivity smaller than 1% or does not have optical permeability substantially, or the sintered compact which comprises a beryllium oxide as the main ingredients and which has the optical transmissivity not less than 1%, are used as a substrate, the light emitting device whose luminous efficiency is at least not less than 8% is producible.

Usually, as for the sintered compact which comprises a beryllium oxide as the main ingredients, if what has high optical permeability is used as a substrate a light emitting device with higher luminous efficiency is producible, it is desirable.

That is, when the sintered compact of optical transmissivity not less than 10% which comprises a beryllium oxide as the main ingredients is used as a substrate, what is not less than 10% as luminous efficiency of the light emitting device formed on it is easy to be obtained.

Moreover, when the sintered compact of optical transmissivity not less than 20% which comprises a beryllium oxide as the main ingredients is used as a substrate, since what is not less than 12% as luminous efficiency of the light emitting device formed on it is easy to be obtained, it is desirable.

Moreover, when the sintered compact of optical transmissivity not less than 30% which comprises a beryllium oxide as the main ingredients is used as a substrate, what is not less than 15% as luminous efficiency of the light emitting device formed on it is easy to be obtained.

Moreover, when the sintered compact of optical transmissivity not less than 40% which comprises a beryllium oxide as the main ingredients is used as a substrate, what is not less than 20% as luminous efficiency of the light emitting device formed on it is easy to be obtained.

Moreover, when the sintered compact of optical transmissivity not less than 50% which comprises a beryllium oxide as the main ingredients is used as a substrate, what is not less than 25% as luminous efficiency of the light emitting device formed on it is easy to be obtained.

In this invention, as mentioned above, the thing whose optical transmissivity is not less than 60% is obtained, and further what is a maximum of not less than 80% is also obtained, when the sintered compact thing which has such high optical transmissivity and comprises a beryllium oxide as the main ingredients was used as a substrate, what is not less than 30% and a maximum of 52% as luminous efficiency of the light emitting device which are formed on it were obtained.

Moreover, if the sintered compact which comprises an aluminum oxide as the main ingredients and which has the optical transmissivity smaller than 1% or does not have optical permeability substantially, or the sintered compact which comprises an aluminum oxide as the main ingredients and which has the optical transmissivity not less than 1%, are used as a substrate, the light emitting device whose luminous efficiency is at least not less than 8% is producible.

Usually, as for the sintered compact which comprises an aluminum oxide as the main ingredients, if what has high optical permeability is used as a substrate, a light emitting device with higher luminous efficiency is producible, it is desirable.

That is, when the sintered compact of optical transmissivity not less than 10% which comprises an aluminum oxide as the main ingredients is used as a substrate, what is not less than 10% as luminous efficiency of the light emitting device formed on it is easy to be obtained.

Moreover, when the sintered compact of optical transmissivity not less than 20% which comprises an aluminum oxide as the main ingredients is used as a substrate, since what is not less than 12% as luminous efficiency of the light emitting device formed on it is easy to be obtained, it is desirable.

Moreover, when the sintered compact of optical transmissivity not less than 30% which comprises an aluminum oxide as the main ingredients is used as a substrate, what is not less than 15% as luminous efficiency of the light emitting device formed on it is easy to be obtained.

Moreover, when the sintered compact of optical transmissivity not less than 40% which comprises an aluminum oxide as the main ingredients is used as a substrate, what is not less than 20% as luminous efficiency of the light emitting device formed on it is easy to be obtained.

Moreover, when the sintered compact of optical transmissivity not less than 50% which comprises an aluminum oxide as the main ingredients is used as a substrate, what is not less than 25% as luminous efficiency of the light emitting device formed on it is easy to be obtained.

In this invention, as mentioned above, what is not less than 60% is obtained as optical transmissivity, and further what is a maximum of not less than 80% is also obtained, when the sintered compact thing which has such high optical transmissivity and comprises an aluminum oxide as the main ingredients was used as a substrate, what is not less than 30% and a maximum of 51% as luminous efficiency of the light emitting device which are formed on it were obtained.

Thus, as for the luminous efficiency of the light emitting device produced using as a substrate the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., since what has not less than 8% is easy to be obtained, the light emitting device which is at least equivalent or which has been improved to a maximum of not less than 3-4 times can be provided if it is compared with the luminous efficiency of the light emitting device produced using the conventional substrates, such as sapphire etc.

In this invention, if it is what can form the single crystal thin film which comprises as the main ingredients at least one or more materials selected from a gallium nitride, an indium nitride, and an aluminum nitride as various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., even if crystal grains, such as a silicon carbide, a silicon nitride, a zinc oxide, a beryllium oxide, and an aluminum oxide, in this sintered compact, are what kind of size, the light emitting device which has excellent luminous efficiency can be produced using as a substrate these various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

Usually, the light emitting device which is at least equivalent if it is compared with the luminous efficiency of the light emitting device produced using conventional substrates, such as sapphire etc., or which has been improved to a maximum of not less than 3-4 times as luminous efficiency of this light emitting device can be provided.

Usually, it is preferred to use as a substrate various sintered compacts which have an average of not less than 0.5 μm as a size of crystal grains and which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., the light emitting device which is at least equivalent or which has been improved to a maximum of not less than 3-4 times can be produced if it is compared with the luminous efficiency of the light emitting device produced using the conventional substrates, such as sapphire etc.

If saying in more detail, if the various sintered compacts in which the size of crystal grains is an average of not less than 1.0 μm and comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., are used as a substrate, the light emitting device whose luminous efficiency is at least not less than 8% can be produced.

Moreover, even if it uses as a substrate the various sintered compacts which have not only what is in the state where the crystal grain contained is equal to the equally near size but also what has the irregular size of a crystal grain or the crystal grain whose form is distorted and which is the thing whose one side is small and whose other one side is large, for example, such as the shape of needlelike or a boardlike whose one side grew up into several Jm and whose other one side grew up into about ten or more Jlm greatly, such as a β-Si₃N₄ particle, and which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., the light emitting device which is excellent in luminous efficiency satisfactory at all is producible.

In addition to this, even if it uses as a substrate the thing which formed the conduction via in the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., the single crystal thin film which comprises as the main ingredients at least one or more materials selected from a gallium nitride, an indium nitride, and an aluminum nitride can be formed, the light emitting device which has excellent luminous efficiency can produce.

It is possible to use anything, if it is the material which has conductivity as a conduction via.

Usually, the material which comprises as the main ingredients a material, such as tungsten, molybdenum, gold, silver, copper, and titanium nitride, as a material of a conduction via is used.

If using as a substrate the various sintered compacts in which the conduction via which consists of such material was formed and which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., usually, the light emitting device which is at least equivalent or which has been improved to a maximum of not less than 3-4 times can be provided if it is compared with the luminous efficiency of the light emitting device produced by using the conventional substrates, such as sapphire etc.

If it says in more detail, the light emitting device whose luminous efficiency is at least not less than 8% can be produced using as a substrate what formed the conduction via in the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

As mentioned above, it explained that it is effective to have used the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., as a substrate for making a light emitting device, and especially if it is what has optical permeability, the light emitting device which is more excellent in luminous efficiency can produce.

And in this invention, even if it is what is in what kind of state as surface smooth nature of the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., if it is what can form the single crystal thin film which comprises as the main ingredients at least one or more materials selected from a gallium nitride, an indium nitride, and an aluminum nitride, what has excellent luminous efficiency can be produced as the light emitting device which is formed on this substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

Usually, as for the luminous efficiency of the light emitting device produced using the substrate which consists of various sintered compacts which have the above-mentioned surface smooth nature and comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., what is at least equivalent or what has been improved to a maximum of not less than 3-4 times can be provided if it is compared with the luminous efficiency of the light emitting device produced by using the conventional substrates, such as sapphire etc.

If it says in more detail, 1) in the case of the method of producing the light emitting device, such as, using as a substrate the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., as it is, if it requires, the buffer layer which consists of a thin film which comprises as the main ingredients at least one or more materials selected from a gallium nitride, an indium nitride, and an aluminum nitride will be first formed directly on it, and the epitaxially grown single crystal thin film which comprises as the main ingredients at least one or more materials selected from a gallium nitride, an indium nitride, and an aluminum nitride will be laminated on it as N type semiconductor layer, a luminescence layer, and P type semiconductor layer, usually, the light emitting device whose luminous efficiency is at least not less than 8% can be produced by using what is not more than 1000 nm as average surface roughness Ra of the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

And, there are methods, such as, 2) the method of producing the light emitting device, such as, making as a substrate the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., a thin film substrate will be made by beforehand forming at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., on it, if it requires, the buffer layer which consists of a thin film which comprises as the main ingredients at least one or more materials selected from a gallium nitride, an indium nitride, and an aluminum nitride will be first formed on it, and the epitaxially grown single crystal thin film which comprises as the main ingredients at least one or more materials selected from a gallium nitride, an indium nitride, and an aluminum nitride will be laminated on it as N type semiconductor layer, a luminescence layer, and P type semiconductor layer, and 3) the method of producing the light. emitting device, such as, making as a substrate the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., will be formed beforehand on it, and a thin film substrate will be made by forming furthermore at least one or more layers of single crystal thin films which comprise as the main ingredients at least one or more materials selected from a gallium nitride, an indium nitride, and an aluminum nitride on it, if it requires, the buffer layer which consists of a thin film which comprises as the main ingredients at least one or more materials selected from a gallium nitride, an indium nitride, and an aluminum nitride will be first formed on this thin film substrate, and the epitaxially grown single crystal thin film which comprises as the main ingredients at least one or more materials selected from a gallium nitride, an indium nitride, and an aluminum nitride will be laminated on it as N type semiconductor layer, a luminescence layer, and P type semiconductor layer, when producing a light emitting device by the method explained in the above 2)-3), usually, even if what is more than 1000 nm as average surface roughness Ra of the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., is used, the light emitting device whose luminous efficiency is at least not less than 8% can be produced.

In this invention, even if the thickness of the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., is what kind of thing, if it is what can form the single crystal thin film which comprises as the main ingredients at least one or more materials selected from a gallium nitride, an indium nitride, and an aluminum nitride, what has excellent luminous efficiency can be produced as the light emitting device which is formed on this substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

Usually, as for the luminous efficiency of the light emitting device produced using the substrate which consists of various sintered compacts which have the above-mentioned substrate thickness and comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., what is at least equivalent or what has been improved to a maximum of not less than 3-4 times can be provided if it is compared with the luminous efficiency of the light emitting device produced by using the conventional substrates, such as sapphire etc.

Usually, the light emitting device whose luminous efficiency is at least not less than 8% can be produced using what has not more than 8.0 mm as the thickness of the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

In the above, it is effective to use the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., as a substrate for making a light emitting device, the effect of purity (composition), optical transmissivity, sintered compact crystal grain, existence of a conduction via, surface smooth nature as a substrate, and thickness of a substrate etc. have been explained about these various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

It has explained above, a) the method of producing the light emitting device, such as, making as a substrate the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., a thin film substrate will be made by beforehand forming at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., on it, then N type semiconductor layer, a luminescence layer, and P type semiconductor layer will be laminated on this thin film substrate, and b) the method of producing the light emitting device, such as, making as a substrate the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., will be formed beforehand on it, and a thin film substrate will be made by forming furthermore at least one or more layers of single crystal thin films which comprise as the main ingredients at least one or more materials selected from a gallium nitride, an indium nitride, and an aluminum nitride on it, then N type semiconductor layer, a luminescence layer, and P type semiconductor layer will be laminated on this thin film substrate, when producing a light emitting device by the method explained in the above a), b), in the case of that whose thin film which comprises as the main ingredients at least one or more materials selected from a gallium nitride, an indium nitride, and an aluminum nitride and is formed beforehand on the substrate which consists of various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., is what has at least one of the crystallized states selected from a single crystal, an amorphous state, a polycrystal, and an orientated polycrystal, unless reference is made especially, on it, the light emitting device of luminous efficiency not less than 8% can usually produce.

Among the above-mentioned thin film which forms beforehand on the substrate and comprises as the main ingredients at least one or more materials selected from a gallium nitride, an indium nitride, and an aluminum nitride, what has at least one of the crystallized states selected from an amorphous state, a polycrystal, and an orientated polycrystal is more preferred.

Moreover, in the thing whose thin film which forms beforehand on the substrate and comprises as the main ingredients at least one or more materials selected from a gallium nitride, an indium nitride, and an aluminum nitride has the crystallized state of an orientated polycrystal, unless reference is made especially, on it, the light emitting device whose luminous efficiency is not less than 10% can be produced usually.

Moreover, if the substrate which has at least two or more layers of thin films comprising at least one or more materials selected from a gallium nitride, an indium nitride, and an aluminum nitride as the main ingredients and whose surface one among these thin films of two or more layers is the single crystal is used, regardless of the crystallized states of the thin films which form beforehand on a substrate, the light emitting device whose luminous efficiency is at least not less than 10% can be produced on it.

In this invention, not only in the above-mentioned various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., but also in the various sintered compacts which comprise as the main ingredients a ceramic material, such as a zirconium dioxide (ZrO₂), a magnesium oxide (MgO), a magnesium aluminate (MgAl₂O₄), a titanium oxide (TiO₂), a barium titanate (BaTiO₃), a lead titanate zirconate (PZT), rare earth oxides such as a yttrium oxide (Y₂O₃), a thorium dioxide (ThO₂), various ferrites (Fe₃O₄, etc.), a mullite (3Al₂O₃.2SiO₂), a forsterite (2MgO.SiO₂), a steatite (MgO.SiO₂), and glass ceramics etc., a light emitting device excellent in luminous efficiency is producible using what has optical permeability as a substrate.

Usually, for example, if the above-mentioned various sintered compacts which comprise as the main ingredients a ceramic material and has optical permeability, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc., are used as a substrate as it is, except for the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., since it is difficult to form directly the epitaxially grown single crystal thin film which comprises as the main ingredients at least one or more materials selected from a gallium nitride, an indium nitride, and an aluminum nitride, onto it in many cases, it is usually difficult to produce the light emitting device which has good luminous efficiency by the method which produces the light emitting device by laminating the single crystal thin film which grew epitaxially as N type semiconductor layer, a luminescence layer, and P type semiconductor layer and using each above-mentioned sintered compact as it is.

However, for example, when a thin film substrate is made by forming beforehand at least one or more layers of the thin films which comprise as the main ingredients at least one or more materials selected from a gallium nitride, an indium nitride, and an aluminum nitride and have at least one of the crystallized states selected from an amorphous state, a polycrystal, and an orientated polycrystal onto the above-mentioned substrate which consists of various sintered compacts which comprise as the main ingredients a ceramic material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc., on this thin film substrate, it becomes possible to laminate the epitaxially grown single crystal thin film which comprises as the main ingredients at least one or more materials selected from a gallium nitride, an indium nitride, and an aluminum nitride and which constitutes a light emitting device as N type semiconductor layer, a luminescence layer, P type semiconductor layer, or a buffer layer, even if it is the thing in which the optical transmissivity is smaller than 1% or which does not have optical permeability substantially, the light emitting device whose luminous efficiency is at least not less than 8% is producible.

In this case, it is also possible to use at least a part of thin film which comprises as the main ingredients at least one or more materials selected from a gallium nitride, an indium nitride, and an aluminum nitride which is formed beforehand, the indium nitride, and the aluminum nitride as a constituent factor of a light emitting device.

In this invention, at least one or more layers of thin films which comprise as the main ingredients at least one or more materials selected from a gallium nitride, an indium nitride, and an aluminum nitride and have at least one of the crystallized states selected from an amorphous state, a polycrystal, an orientated polycrystal, and a single crystal is formed beforehand on the above-mentioned substrate which consists of various sintered compacts which comprise as the main ingredients a ceramic material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc., a thin film substrate is made by forming furthermore at least one or more layers of single crystal thin films which comprise as the main ingredients at least one or more materials selected from a gallium nitride, an indium nitride, and an aluminum nitride on it, and a thin film substrate is made by forming furthermore at least one or more layers of single crystal thin films which comprise as the main ingredients at least one or more materials selected from a gallium nitride, an indium nitride, and an aluminum nitride on it, even if it is the thing in which the optical transmissivity is smaller than 1% or which does not have optical permeability substantially, since the light emitting device which has luminous efficiency at least 10% can produce now using this thin film substrate, it is desirable.

Thus, in this invention, if the above-mentioned substrate which consists of various sintered compacts which comprise as the main ingredients a ceramic material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc., is used, what is at least equivalent or what has been improved to a maximum of not less than 2-3 times can be provided if it is compared with the luminous efficiency of the light emitting device produced by using the conventional sapphire substrate.

In this invention, as for the above-mentioned various sintered compacts which comprise as the main ingredients a ceramic material, such as a zirconium dioxide, a magnesium oxide, a magnesium aluminate, a titanium oxide, a barium titanate, a lead titanate zirconate, rare earth oxide such as a yttrium oxide, a thorium dioxide, various ferrites, a mullite, a forsterite, a steatite, and glass ceramics etc., what has optical transmissivity at least not less than 1%, usually not less than 10%, can be produced.

As for the above-mentioned sintered compacts which comprise as the main ingredients at least one or more materials selected from a zirconium dioxide, a magnesium oxide, a magnesium aluminate, a titanium oxide, a barium titanate, a lead titanate zirconate (especially what contains a rare earth element ingredient), rare earth oxides, such as a yttrium oxide, a thorium dioxide, various ferrites, a mullite, a forsterite, a steatite, and glass ceramics, what is the optical transmissivity not less than 50% can produce, and what is a maximum of not less than 80% is also producible.

It is preferred to use the sintered compacts which comprise as the main ingredients at least one or more materials selected from a zirconium dioxide, a magnesium oxide, a magnesium aluminate, rare earth oxides, such as a yttrium oxide, a thorium oxide, a mullite, and glass ceramics in it.

Moreover, especially, as for the sintered compact which comprises a zirconium dioxide as the main ingredients and which contains a rare earth element compound, such as Y₂O₃, or an alkaline-earth-metals compound, such as CaO, the sintered compact which comprises a magnesium oxide as the main ingredients and contains an alkaline metal, such as LiF or NaF, or an alkaline-earth metal, such as CaO, or a rare earth element compound, such as Y₂O₃, the sintered compact which consists only of a magnesium oxide substantially and which does not contain any ingredients other than the impurities mixing from the raw materials and manufacturing process, the sintered compact which comprises a magnesium aluminate as the main ingredients and contains an alkaline-earth metal, such as CaO, or a rare earth element compounds, such as Y₂O₃, the sintered compact which consists only of a magnesium aluminate substantially and which does not contain any ingredients other than the impurities mixing from the raw materials and manufacturing process, the sintered compact which comprises as the main ingredients a rare earth element oxide, such as Y₂O₃, and which contains a different rare earth element ingredient, and the sintered compact which consists substantially only of a rare earth element oxide, such as Y₂O₃ etc., and which does not contain any ingredients other than the impurities mixing from the raw materials and manufacturing process, since the thing excellent in optical permeability is producible, it is more desirable.

Making into a substrate such various sintered compacts which comprise a ceramic material as the main ingredients and which have optical permeability, if that whose thin film which comprises as the main ingredients at least one or more materials selected from a gallium nitride, an indium nitride, and an aluminum nitride and has various crystallized states, such as a single crystal, an amorphous state, a polycrystal, and an orientated polycrystal etc., was formed beforehand on this substrate is used as a substrate, since the single crystal thin film which comprises as the main ingredients at least one or more materials selected from a gallium nitride, an indium nitride, and an aluminum nitride can be formed on it, by using such substrate on which the single crystal thin film is formed, a light emitting device is producible by forming a thin film anew on it, or a light emitting device is also producible using the single crystal thin film formed by doing in this way as at least a part of thin film layer which constitutes a light emitting device as it is.

In this invention, as for the light emitting device which is produced using as a substrate what has optical permeability among the above-mentioned sintered compacts which comprise as the main ingredients each material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc., the thing in which the luminous efficiency is equivalent at least or which has been improved to a maximum of not less than 2-3 times can be provided if it is compared with the light emitting device produced by using the conventional sapphire substrate.

If it says more concretely, as for the light emitting device which is produced using as a substrate what has optical transmissivity not less than 10% among the above-mentioned sintered compacts which comprise as the main ingredients each material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc., what has luminous efficiency not less than 10% can be produced.

And, in case of the light emitting device produced by using as a substrate what has the optical transmissivity not less than 20%, what has luminous efficiency not less than 12% can be produced.

And, in case of the light emitting device which is produced by using as a substrate what has the optical transmissivity not less than 30%, what has luminous efficiency not less than 15% can be produced.

And, in case of the light emitting device which is produced by using as a substrate what has the optical transmissivity not less than 40%, what has luminous efficiency not less than 20% can be produced.

And, in the case of the light emitting device which is produced by using as a substrate what has the optical transmissivity not less than 50%, what has luminous efficiency not less than 25% can be produced.

And, in the case of the light emitting device which is produced by using as a substrate what has the optical transmissivity not less than 60%, what has luminous efficiency not less than 30% can be produced.

Moreover, in this invention, what has optical permeability of 83% and 81%, respectively, was produced in the substrate which consists of a sintered compact which comprises a magnesium oxide and a magnesium aluminate as the main ingredients, the light emitting device which was produced by using these substrates was excellent luminous efficiency with a maximum of 51% and 50%, respectively.

As it has been explained above, in this invention, producing as a substrate various sintered compacts which comprise as the main ingredients a ceramic material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc., and a thin film substrate is made forming beforehand at least one or more layers of thin films which comprise as the main ingredients at least one or more materials selected from a gallium nitride, an indium nitride, and an aluminum nitride and which have at least one of the crystallized states selected from an amorphous state, a polycrystal, and an orientated polycrystal, onto it, when producing a light emitting device by the method producing the light emitting device on this thin film substrate, what has luminous efficiency not less than 8% can be usually produced as a light emitting device produced.

And, at least one or more layers of thin films which comprise as the main ingredients at least one or more materials selected from a gallium nitride, an indium nitride, and an aluminum nitride and have at least one of the crystallized states selected from an amorphous state, a polycrystal, and an orientated polycrystal is formed beforehand on the substrate which consists of various sintered compacts which comprises as the main ingredients a ceramic material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc., and a thin film substrate is made forming furthermore at least one or more layers of single crystal thin films which comprise as the main ingredients at least one or more materials selected from a gallium nitride, an indium nitride, and an aluminum nitride, onto it, the light emitting device which has luminous efficiency of at least 10% can be produced using this thin film substrate.

The feature of the light emitting device according to this invention is in the point of having used as a substrate the sintered compact which comprises an aluminum nitride as the main ingredients, the various sintered compacts which comprise as the main ingredients a ceramic material which has the crystal structure which can be classified as a hexagonal system, such as a silicon carbide, a silicon nitride, a zinc oxide, and a beryllium oxide etc., and can be classified as a trigonal system or a hexagonal system, such as an aluminum oxide etc., and other than these, the various sintered compacts which comprise as the main ingredients a ceramic material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics, etc.

If it says in detail, as the substrate for producing the light emitting device according to this invention, there are at least two kinds of substrates, one is what uses the sintered compact as a substrate as it is, such as the sintered compact which comprises an aluminum nitride as the main ingredients, and the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., and other one is what uses the thin film substrate forming at least one or more layers of thin films which comprise as the main ingredients at least one or more materials selected from a gallium nitride, an indium nitride, and an aluminum nitride and which have at least one of crystal states selected from an amorphous state, a polycrystal, an orientated polycrystal, and a single crystal etc., onto the substrate which is made from the sintered compact which comprises an aluminum nitride as the main ingredients, the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., and other than these, the various sintered compacts which comprise as the main ingredients a ceramic material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc.

And, in this thin film substrate, there are some which were used as a thin film substrate by forming furthermore at least one or more layers of single crystal thin films which comprise as the main ingredients at least one or more materials selected from a gallium nitride, an indium nitride, and an aluminum nitride onto the one which formed beforehand at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., onto the substrate which is made from the sintered compact which comprises an aluminum nitride as the main ingredients, the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., and other than these, the various sintered compacts which comprise as the main ingredients a ceramic material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc.

In this invention, among the above-mentioned substrates which consists of various sintered compacts which comprise a ceramic material as the main ingredients, since the light emitting device which is more excellent in luminous efficiency will be easy to be obtained if the sintered compact which comprises an aluminum nitride as the main ingredients is used, it is desirable.

That is, concretely, there are, such as what uses the sintered compact which comprises an aluminum nitride as the main ingredients as a substrate as it is, and what is made into the thin film substrate by forming at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., on the substrate which is made from a sintered compact which comprises an aluminum nitride as the main ingredients, and what is made into the thin film substrate by beforehand forming at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., on the substrate which is made from a sintered compact which comprises an aluminum nitride as the main ingredients among these thin film substrates, and on it forming furthermore at least one or more layers of single crystal thin films which comprise as the main ingredients at least one or more materials selected from a gallium nitride, an indium nitride, and an aluminum nitride.

And, among the above-mentioned substrates which consists of various sintered compacts which comprise a ceramic material as the main ingredients, the light emitting device which is comparatively excellent in luminous efficiency will be easy to be obtained if the sintered compact which comprises a zinc oxide as the main ingredients is used, and what has the conductive of not more than 1×10² Ω·cm of electric resistivity in room temperature can also be produced, even if this sintered compact which comprises a zinc oxide as the main ingredients is what has the optical transmissivity not more than 10% or has still smaller optical permeability, such as optical transmissivity of 0%, since the light emitting device of up-and-down electrical connection type electrode arrangement can be produced, it is desirable.

And, among the above-mentioned substrates which consists of various sintered compacts which comprise a ceramic material as the main ingredients, since the light emitting device which is more excellent in luminous efficiency will be easy to be obtained if the sintered compact which has optical permeability is used, it is desirable.

Since what has conductivity simultaneously with optical permeability is obtained as the above-mentioned sintered compact which comprises a zinc oxide as the main ingredients the light emitting device of the up-and-down electrical connection type electrode arrangement which is excellent in luminous efficiency can be produced, it is preferred.

As for the above-mentioned thin film substrate which formed at least one or more layers of thin films which comprise as the main ingredients at least one or more materials selected from a gallium nitride, an indium nitride, and an aluminum nitride and which have at least one of crystal states selected from an amorphous state, a polycrystal, an orientated polycrystal, and a single crystal etc., onto the sintered compact which comprises an aluminum nitride as the main ingredients, the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., and other than these, the various sintered compacts which comprise as the main ingredients a ceramic material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc., it can use not only in the state where this thin film which comprises as the main ingredients at least one or more materials selected from a gallium nitride, an indium nitride, and an aluminum nitride and which has at least one of crystal states selected from an amorphous state, a polycrystal, an orientated polycrystal, and a single crystal etc., was formed on this thin film substrate as it is, but also in the state where this thin film was polished, such as a mirror surface.

Moreover, as for the thin film substrate which formed furthermore at least one or more layers of single crystal thin films which comprise as the main ingredients at least one or more materials selected from a gallium nitride, an indium nitride, and an aluminum nitride onto the one which formed beforehand at least one or more layers of thin films which comprise as the main ingredients at least one or more materials selected from a gallium nitride, an indium nitride, and an aluminum nitride and have at least one of crystal states selected from an amorphous state, a polycrystal, an orientated polycrystal, and a single crystal etc., onto the sintered compact which comprises an aluminum nitride as the main ingredients, the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., and other than these, the various sintered compacts which comprise as the main ingredients a ceramic material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc., it can use not only in the state where the single crystal thin film which comprises as the main ingredients at least one or more materials selected from a gallium nitride, an indium nitride, and an aluminum nitride was formed on this thin film substrate as it is, but also in the state where this single crystal thin film was polished, such as a mirror surface.

As for surface flat and smooth nature of the above-mentioned thin film substrate, even if it is in the state where the thin film was formed as it is, what is at least not more than 10 nm is obtained for average surface roughness Ra, moreover a thin film substrate of which average surface roughness Ra is not more than 3 nm, or not more than 2 nm, or not more than 1 nm, can also be produced comparatively easily spontaneously.

And, by the specular surface polish of this thin film substrate by using at least a mechanochemical method etc., what is at least not more than 10 nm is obtained for average surface roughness Ra, moreover a thin film substrate of which average surface roughness Ra is not more than 3 nm, or not more than 2 nm, or not more than 1 nm, can also be produced comparatively easily spontaneously.

Therefore, even if the spontaneous surface smooth nature of the thin film which is formed on the substrate is low, the thin film substrate of the target surface smooth nature is producible by using the above-mentioned method of polishing or grinding etc.

The light emitting device which is excellent in luminous efficiency can be produced by using the thin film substrate which has such surface smooth nature.

As for the light emitting device according to this invention, as mentioned above, there is a big feature in the point of having used as a substrate the sintered compact which comprises an aluminum nitride as the main ingredients, the various sintered compacts which comprise as the main ingredients a ceramic material which has the crystal structure which can be classified as a hexagonal system, such as a silicon carbide, a silicon nitride, a zinc oxide, and a beryllium oxide etc., and can be classified as a trigonal system or a hexagonal system, such as an aluminum oxide etc., and other than these, the various sintered compacts which comprise as the main ingredients a ceramic material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics, etc.

Moreover, the point of using what has optical permeability is the big feature.

In this invention, the light emitting device can be provided by the method, such as by using such these substrates which consist of a sintered compact which comprises a ceramic material as the main ingredients as it is, then producing on it, or after forming the thin film which comprises as the main ingredients at least one or more materials selected from a gallium nitride, an indium nitride, and an aluminum nitride on such these substrates which consist of a sintered compact which comprises a ceramic material as the main ingredients, then producing on it, or after making into a thin film substrate by forming the thin film which comprises as the main ingredients at least one or more materials selected from a gallium nitride, an indium nitride, and an aluminum nitride on such these substrates which consist of a sintered compact which comprises a ceramic material as the main ingredients, then producing on this thin film substrate.

As the above-mentioned substrate which consists of a sintered compact which comprises a ceramic material as the main ingredients, what is illustrated in FIG. 3, FIG. 5-FIG. 8, FIG. 10-FIG. 20, and FIG. 36-FIG. 38 is used suitably.

The thin film which comprises as the main ingredients at least one or more materials selected from a gallium nitride, an indium nitride, and an aluminum nitride and is formed on the substrate which comprises a ceramic material as the main ingredients before producing the above-mentioned light emitting device, and the thin film which comprises as the main ingredients at least one or more materials selected from a gallium nitride, an indium nitride, and an aluminum nitride and is formed on the substrate which comprises a ceramic material as the main ingredients for producing the thin film substrate, are formed usually by the methods, such as a Sputtering method, or an Ion plating method, or a Vapor deposition, or an MOCVD method, or an MOVPE method, or other CVD methods, a Chloride VPE method, or other Halide VPE methods, or an MBE method, etc.

As this thin film, what is various crystallized states, such as a single crystal, an amorphous state, a polycrystal, and an orientated polycrystal, can be used.

As this thin film what is a single layer or what is the multilayer constitution of at least two or more layers can also be used satisfactory.

When forming this thin film as a single layer, if it is formed in at least one of the crystallized states which is selected from an state, a polycrystal, and an orientated polycrystal, since the single crystal thin film in which the characteristics, such as crystallinity and surface smooth nature, are more excellent can be formed on it, it is desirable when raising the luminous efficiency of a light emitting device.

When forming this thin film as a single layer, if it is formed in the crystallized state of an orientated polycrystal, since the single crystal thin film in which the characteristics, such as crystallinity and surface smooth nature, are still more excellent can be formed on it, it is still more desirable.

When forming in the orientated polycrystalline state or in the single crystal state among these thin films, that whose C axis of a crystal was perpendicularly formed to the substrate surface is usually used.

This thin film may comprise two or more layers (for example, composition differs or crystallized states differ) instead of a single layer constitution as mentioned above.

Since the thin film of a surface layer can be formed as a single crystal excellent in crystallinity when this thin film is formed by two or more layers, on it, the light emitting device which is excellent in luminous efficiency is producible.

In order to form the single crystal thin film more excellent in crystallinity, it is preferred to form beforehand the thin film of at least one of the crystallized states selected from an amorphous state, a polycrystal, and an orientated polycrystal on the above-mentioned substrate which consists of a sintered compact which comprises a ceramic material as the main ingredients.

It is still more preferred to form the thin film of an orientated polycrystalline state beforehand.

Although this thin film has conductivity, it does not necessarily need to have conductivity.

Conductivity can be given comparatively easily by making this thin film into N type semiconductor or P type semiconductor by adding doping ingredients, such as Si (silicon), Ge(germanium), Se (selenium), Te (tellurium), O (oxygen), Mg (magnesium), Be (beryllium), Ca (calcium), Zn (zinc), Cd (cadmium), and C (carbon), etc. to the main ingredients in this thin film.

Hereafter, a light emitting device is explained using a figure.

FIG. 39 is a sectional view showing the fundamental constitution of a light emitting device.

That is, the buffer layer 31 is formed on the substrate 30 for light emitting device production from the thin film which comprises as the main ingredients at least one or more materials selected from a gallium nitride, an indium nitride, and an aluminum nitride, and the thin film layer 34 is formed on it from the thin film which has the N type or the P type semiconductor characteristic and comprises as the main ingredienttat least one or more materials selected from a gallium nitride, an indium nitride, and an aluminum nitride.

The luminescence layer 36 is formed on it by the thin film which comprises as the main ingredients at least one or more materials selected from a gallium nitride, an indium nitride, and an aluminum nitride.

The thin film layer 35 is formed on it by the thin film which has the P type or the N type semiconductor characteristic and comprises as the main ingredienttat least one or more materials selected from a gallium nitride, an indium nitride, and an aluminum nitride.

If the thin film layer 34 has the N type semiconductor characteristic, this thin film layer 35 is set up so that it may become the P type semiconductor characteristic, if the thin film layer 34 has the P type semiconductor characteristic, this thin film layer 35 is set up so that it may become the N type semiconductor characteristic.

An electrode 38 is formed in the thin film layer 34 and the thin film layer 35, respectively. Thus, if it requires, on a substrate 30, the buffer layer 31 will be formed first, on it, N type semiconductor layer (P type semiconductor layer) 34, the luminescence layer 36, and P type semiconductor layer (N type semiconductor layer) 35 are laminated, an electrode 38 is formed furthermore, and a light emitting device 32 is constituted as a whole including a substrate.

A light emitting device drives by applying direct-current electric power to the electrode 38 formed in N type semiconductor layer and P type semiconductor layer.

Light can be emitted over the wide wavelength range of an ultraviolet-rays domain to a visible light domain, for example, as the wavelength of luminescence, by adjusting composition of a luminescence layer etc.

Speaking concretely, being able to emit the light of the wavelength range of 250 nm-650 nm, for example, it is usually produced in many cases so that the light of the wavelength range of 300 nm-600 nm may be emitted.

If it explains in detail, in FIG. 39, for example, sapphire etc. have been used conventionally as a substrate 30 for light emitting device production.

In this invention, as a substrate 30 for light emitting device production, for example, as illustrated in FIG. 3, FIG. 5-FIG. 8, FIG. 10-FIG. 20, and FIG. 36-FIG. 38, there are some which were used as a substrare the sintered compact which comprises an aluminum nitride as the main ingredients, the sintered compact which comprises as the main ingredients a ceramic material which has the crystal structure which can be classified as a hexagonal system, such as a silicon carbide, a silicon nitride, a zinc oxide, and a beryllium oxide etc., and can be classified as a trigonal system or a hexagonal system, such as an aluminum oxide etc., and other than these, the various sintered compacts which comprise as the main ingredients a ceramic material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics, etc., in the state as it is, or there are some which were used as a thin film substrate which formed the thin film which comprises as the main ingredients at least one or more materials selected from a gallium nitride, an indium nitride, and an aluminum nitride onto these substrates which consist of a sintered compact which comprises a ceramic material as the main ingredients.

On a substrate 30, the buffer layer 31 which consists of a thin film which comprises as the main ingredients at least one or more materials selected from a gallium nitride, an indium nitride, and an aluminum nitride by methods, such as the MOCVD method, the MOVPE method, the other CVD methods, the chloride VPE method, or the MBE method, is formed.

Although what is an amorphous state is usually used as a buffer thin film layer 31, in addition to this, what is various crystallized states, such as a polycrystal and an orientated polycrystal, can also be used, and further what is the single crystal state which grew epitaxially can also be used.

Although the buffer layer 31 may have conductivity made into semiconductor of N type or P type, it does not necessarily need to have conductivity.

On the buffer layer 31, the thin film layer 34 which has the N type or the P type semiconductor characteristic and is constituted by the epitaxially grown thin film which comprises as the main ingredients at least one or more materials selected from a gallium nitride, an indium nitride, and an aluminum nitride by the methods, such as the MOCVD method, the MOVPE method, the other CVD methods, the chloride VPE method, or the MBE method, is being formed.

It is provided in order for the above-mentioned buffer layer 31 to usually adjust the crystal mismatching between a substrate 30 and the thin film layer 34 and to improve the characteristics, such as the crystallinity of the thin film layer 34, and surface smooth nature, but what is necessary is just to provide if needed, even if it does not provide especially in this invention, it is also possible to form the thin film layer 34 directly on a substrate 30, and to produce a light emitting device.

The thin film layer 34 is adjusted so that it may usually have N type semiconductor characteristic, but it may be P type semiconductor.

N type semiconductor characteristic is usually generated by containing the donor formation doping ingredients, such as Si (silicon), Ge (germanium), Se (selenium), Te (tellurium), and O (oxygen), into the main ingredients which constitute this thin film layer 34.

On the thin film layer 34, the luminescence layer 36 which comprises an epitaxially grown thin film which comprises as the main ingredients at least one or more materials selected from a gallium nitride, an indium nitride, and an aluminum nitride is formed.

As the thin film which constitutes the luminescence layer 36, usually, the undoped type thin film which does not contain a doping ingredient, or what contains one or more ingredients selected from acceptor formation doping ingredient, what contains one or more ingredients selected from donor formation doping ingredient, or the thin film which contains simultaneously each one or more ingredients selected from acceptor formation doping ingredient and donor formation doping ingredient (that is co-doping), is used suitably.

The wavelength of the light emitted from a luminescence layer is controllable by composition of GaN, InN, and AlN which are used as a luminescence layer, or by the kind of doping ingredient.

The luminescence layer 36 could be formed from the single thin film layer, for example, like hetero structure or double hetero structure or single quantum well structure, and could comprise two or more layers, for example, like multi-quantum-well structure.

In the case of single quantum well structure, the luminescence layer 36 consists of a thin single thin film layer of the single composition of, for example, not more than 100A used as a well layer, and it is the structure inserted in the barrier layer of N type semiconductor thin film, and the barrier layer of P type semiconductor thin film.

Moreover, for the luminescence layer 36, the thing of the multi-quantum-well structure which is constituted by laminating by turns the thin thin film of at least two or more different composition and is used as the well layer and barrier layer can also be used.

In the case of multi-quantum-well structure, as for the thickness of a well layer and a barrier layer, as a well layer what is 150A, preferably what is not more than 100A, more preferably what is not more than 70A, and as a barrier layer what is not more than 200A, preferably what is not more than 150A, more preferably what is not more than 100A, are usually used.

As for two thin film layers in the most outer layer, in the case of multi-quantum-well structure, usually being formed in a well layer is preferred.

The light emitting device of the above-mentioned hetero structure or double hetero structure or single quantum well structure is usually used as a light emitting diode (LED), and the light emitting device which has multi-quantum-well structure is usually used as a laser diode (LD).

It is preferred that the thin film which will make the well layer and barrier layer which constitute the above-mentioned luminescence layer also usually comprises an epitaxially grown thin film which comprises as the main ingredients at least one or more materials selected from a gallium nitride, an indium nitride, and an aluminum nitride.

Although what has the undoping state which does not add a doping ingredient is usually used as the thin film which will make the well layer of the single quantum well structure and multi-quantum-well structure, what was semiconductor-ized into N type or P type respectively by adding the doping ingredient suitably, or what was semiconductor-ized by simultaneously adding doping ingredient for semiconductor-izig into N type and P type, etc. can be used.

When a luminescence layer is multi-quantum-well structure, what has the undoping state which does not add a doping ingredient is usually used as the thin film which will make the barrier layer, wha was semiconductor-ized into N type or P type by adding the doping ingredient suitably, or what was semiconductor-ized by adding simultaneously doping ingredient for semiconductor-izing into N type and P type respectively, etc. can be used.

As the well layer/barrier layer which constitutes a quantum well layer, there is what has the combination which consists of composition system, for example, such as InGaN/GaN, InGaN/InGaN (composition differs, respectively), InGaN/AlGaN, AlGaN/GaN, etc.

And, the thin film layer 35 constituted by the epitaxially grown thin film which comprises as the main ingredients at least one or more materials selected from a gallium nitride, an indium nitride, and an aluminum nitride is formed on the luminescence layer 36.

When the above-mentioned thin film layer 34 has N type semiconductor characteristic, the thin film layer 35 is adjusted so that it may have P type semiconductor characteristic.

When the above-mentioned thin film layer 34 has P type semiconductor characteristic, it is adjusted so that it may have N type semiconductor characteristic.

P type semiconductor characteristic is usually generated by containing the acceptor formation doping ingredients, such as Mg (magnesium), Be (beryllium), Ca (calcium), Zn (zinc), Cd (cadmium), and C (carbon), into the main ingredients which constitute this thin film layer 35.

In addition, although the above-mentioned donor formation doping ingredient and an acceptor formation doping ingredient can make any rates contain to the main ingredients in order to make a thin film into the N type semiconductor or P type semiconductor, and in order to make electrical resistivity of this thin film low, but they are usually contained in the range of 0.00001-10 mol %.

Even if it is the undoped type which does not contain a doping ingredient as the thin film which comprises as the main ingredients at least one or more materials selected from a gallium nitride, an indium nitride, and an aluminum nitride, it has the N type semiconductor characteristic spontaneously, and conductivity may be generated, it can be used for a light emitting device even if it is such undoped type thin films.

The electrode 38 which comprises Al, Au, Pt, Ti, Ni, Cr, Sn, Al/Ti, Au/Ni, Au/Ti, Au/Pd, Au/Pt/Ti, etc. is formed on the above-mentioned thin film layer 34 and the thin film layer 35, luminescence of a device is performed by direct-current potential being applied from there.

In addition, the above-mentioned thin film layer 34 and the thin film layer 35 may consist of two or more multi layers (for example, composition differs) instead of a respectively single layer constitution.

If it says in more detail, as for the above-mentioned thin film layer 34 and the thin film layer 35, not only what was constituted as a single layer but also what comprises at least two or more-layer thin film layers, for example, at least one of the layers is a contact layer for connecting with an electrode and a cladding layer linked to a luminescence layer, etc., will be used suitably.

And, as for the contact layer and cladding layer which constitute the above-mentioned thin film layer 34 and the thin film layer 35, not only a single layer but also that whose at least either of the layers is constituted from at least two or more thin film layers, respectively, can be used suitably.

And, even if the thin film layer 34 and the thin film layer 35 are respectively single thin film layers or only either is a single thin film layer, it can also be made to function as a barrier layer in case the luminescence layer 36 is used as a well layer of quantum well structure.

For example, when it is going to produce the light emitting device which has single quantum well structure, by forming the luminescence layer 36 of FIG. 36 as a well layer which consists of a thin single thin film layer by single composition of not more than 100A, for example, then by using the thin film layer of a single layer as a barrier layer of this well layer among the thin film layer 34 or the thin film layer 35, the target light emitting device which has the single quantum well structure is also producible.

And, it is the case where the thin film layer 34 and the thin film layer 35 consist of a two or more thin film layers, respectively, or only either consists of a two or more thin film layers, by using the cladding layer which is directly in contact with the luminescence layer among two or more thin film layers as a barrier layer of a well layer, single quantum well structure can also be formed.

As for the above-mentioned thin film layer 34, the thin film layer 35, and the luminescence layer 36, it is preferred that usually it is the single crystal which grew epitaxially in order to raise the luminous efficiency of a light emitting device, respectively.

As for the crystallinity, it is preferred that the half width of the rocking curve of the X ray diffraction line from the lattice plane of the Miller Index (002) of this thin film is not more than 3600 seconds, it is preferred that it is not more than 300 seconds if needed, moreover it is preferred that it is the crystallinity more than it.

Although it is preferred that the thin film layer 34 and the thin film layer 35 are usually in a single crystal state altogether, when this thin film layer 34 and the thin film layer 35 consist of at least two or more layers of a contact layer and a cladding layer, as mentioned above, the contact layer for electrode connection may not necessarily be the crystallized state of not a single crystal state but an amorphous state, a polycrystal, and an orientated polycrystal.

As for the light emitting device according to this invention, using the above-mentioned sintered compact which comprises a ceramic material as the main ingredients is used as a substrate as it is instead of the conventional substrate which consists of sapphire etc., or using the thin film substrate made by forming the thin film which comprises as the main ingredients at least one or more materials selected from a gallium nitride, an indium nitride, and an aluminum nitride onto the substrate, an excellent thing, such as what is at least equivalent if it is compared with the luminous efficiency of the light emitting device produced by using conventional substrates, such as sapphire etc., or what is not less than 2-3 times, or what is not less than 3-4 times, or what is a maximum of not less than 4-5 times, has been obtained.

When the light emitting device is actually produced, it may be the method of preparing only the above-mentioned substrate which consists of a sintered compact which comprises a ceramic material as the main ingredients and forming each thin film layer one by one on it, or it may be the method of preparing the thin film substrate in which at least one or more layers of thin films which comprise as the main ingredients at least one or more materials selected from a gallium nitride, an indium nitride, and an aluminum nitride and which have at least one of the crystallized states selected from a single crystal, an amorphous state, a polycrystal, and an orientated polycrystal etc., were formed beforehand on the above-mentioned substrate which consists of a sintered compact which comprises a ceramic material as the main ingredients and forming each thin film layer one by one on it.

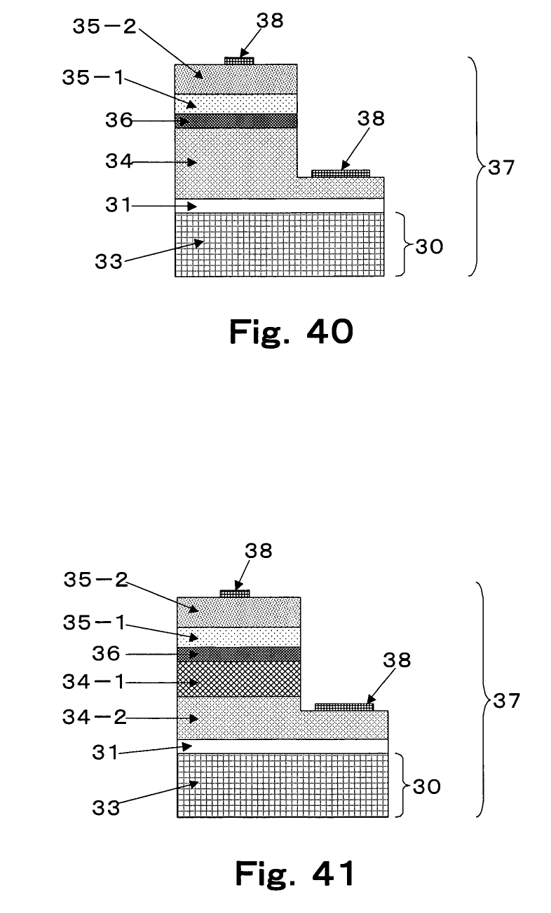

FIG. 40 and 41 are sectional views having shown one example of the light emitting device produced by using conventional substrates, such as sapphire etc.

The light emitting device of the structure illustrated in FIG. 40 is an example in which the thin film layer 35 in FIG. 39 is formed in the state of two layers.

Usually, the light emitting device with single quantum well structure is produced by such thin film constitution.

In FIG. 40, the buffer layer 31 which consists of a thin film which comprises as the main ingredients at least one or more materials selected from a gallium nitride, an indium nitride, and an aluminum nitride is formed on the substrates 33, for example, such as sapphire etc. of which a substrate surface is the C plane (namely, direction where C axis is perpendicular to a substrate surface), by methods, such as the MOCVD method, or the MOVPE method, or the other CVD methods, or the Chloride VPE method, or the MBE method, etc.

A substrate 33 is used as a substrate 30 for light emitting device production as it is.

What usually formed the GaN thin film of an amorphous by the thickness of about 100A-1500A as a buffer thin film layer 31 is used.

On the buffer layer 31, the thin film layer 34 which has the N type or the P type semiconductor characteristic and is constituted by the epitaxially grown thin film which comprises as the main ingredients at least one or more materials selected from a gallium nitride, an indium nitride, and an aluminum nitride, is formed by methods, such as the MOCVD method, or the MOVPE method, or the other CVD methods, or the Chloride VPE method, or the MBE method.

The thin film layer 34 may function also as a barrier layer of a single quantum well layer.

What formed the epitaxially grown single crystal GaN thin film which has the N type semiconductor characteristic that Si etc. was usually doped as a thin film layer 34 by the thickness of about 0.5 μm-20 μm is used.

On the thin film layer 34, the luminescence layer 36 constituted by the epitaxially grown thin film which comprises as the main ingredients at least one or more materials selected from a gallium nitride, an indium nitride, and an aluminum nitride by methods, such as the MOCVD method, or the MOVPE method, or the other CVD methods, or the Chloride VPE method, or the MBE method, is formed.

For example, when producing the light emitting device which has single quantum well structure, as for the luminescence layer 36 what formed the undoped thin film of the epitaxially grown single crystal InGaN mixture composition as a well layer by the thickness of about 5 A-200 A is used usually.

The wavelength of the light emitted from a luminescence layer changes with InGaN composition, that is, luminescence wavelength is about 520 nm (green) by composition of In0.45Ga0.55N, luminescence wavelength is about 450 nm (blue) by composition of In0.20Ga0.80N, luminescence wavelength is about 390 nm (purple) by composition of In0.06Ga0.94N.

On the luminescence layer 36, the thin film layer 35-1 which has the P type or the N type semiconductor characteristic and is constituted by the epitaxially grown thin film which comprises as the main ingredients at least one or more materials selected from a gallium nitride, an indium nitride, and an aluminum nitride by methods, such as the MOCVD method, or the MOVPE method, or the other CVD methods, or the Chloride VPE method, or the MBE method, is formed. The thin film layer 35-1 is adjusted to the P type semiconductor characteristic when the thin film layer 34 is N type semiconductor, the thin film layer 35-1 is adjusted to the N type semiconductor characteristic when the thin film layer 34 is P type semiconductor. The thin film layer 35-1 may function also as a barrier layer of a single quantum well layer. What formed the thin film of the epitaxially grown single crystal AlGaN mixture composition which has the P type semiconductor characteristic that Mg etc. was usually doped as a thin film layer 35-1 by the thickness of about 0.02 μm-1.0 μm is used.

On the thin film layer 35-1, the thin film layer 35-2 which has the same semiconductor characteristic of type as the thin film layer 35-1 constituted from the epitaxially grown thin film which comprises as the main ingredients at least one or more materials selected from a gallium nitride, an indium nitride, and an aluminum nitride by methods, such as the MOCVD method, or the MOVPE method, or the other CVD methods, or the Chloride VPE method, or the MBE method, is formed.

The thin film layer 35-2 usually functions as a contact layer.

What formed the epitaxially grown single crystal GaN thin film which has the P type semiconductor characteristic that Mg etc. was usually doped as a thin film layer 35-2 by the thickness of about 0.05 μm-5 μm is used.

The thin film layer 34 is used not only as the barrier layer of a well layer but also as a contact layer which forms an electrode.

The electrode 38 which comprises Ti/Al or Ni/Au, etc. is formed on the thin film layer 34 and the thin film layer 35.

In addition, in the case of the light emitting device which emits light with short wavelength, such as a purple-blue color, purple, or ultraviolet rays, in order that the thin film layer 34, the thin film layer 35-1, and the thin film layer 35-2 may lessen absorption of luminescence as much as possible, not only what is 100 mol % GaN but also what is formed from the mixed composition AlGaN of AIN and GaN is suitably used as the main ingredients.

Donor formation doping ingredients, such as Si, Ge, Se, Te, and O, and acceptor formation doping ingredients, such as Mg, Be, Ca, Zn, Cd, and C, will make a thin film into N type semiconductor or P type semiconductor, furthermore, what kind of rate can also make these contain to the main ingredients in order to make electric resistivity of this thin film small, but usually they are contained in the range of 0.00001-10 mol %.

As illustrated in FIG. 40, the conventional light emitting device 37 which has single quantum well structure etc. has been formed by the substrate 33 which consists of sapphire etc., buffer layer 31, the thin film layer 34 which has N type semiconductor characteristic (or the thin film layer which has P type semiconductor characteristic), luminescence layer 36, the thin film layer 35-1 which has P type semiconductor characteristic (or the thin film layer which has N type semiconductor characteristic), the thin film layer 35-2 which has P type semiconductor characteristic (or the thin film layer which has N type semiconductor characteristic), and electrode 38.

A light emitting device drives and emits light by applying direct-current electric power to an electrode 38.

The luminous efficiency of the above-mentioned conventional light emitting devices, such as the single quantum well structure produced using substrates, such as sapphire etc., is usually about 2% -8%.

FIG. 41 is a sectional view showing one example of the light emitting device produced using conventional substrates, such as sapphire etc., etc.

The light emitting device of the structure illustrated in FIG. 41 is the example in which the thin film layer 34 and the thin film layer 35 in FIG. 39 were formed in the state of every two layers, respectively.

Usually, the light emitting device of double hetero structure is produced by such thin film constitution.

In FIG. 41, the buffer layer 31 which consists of a thin film which comprises as the main ingredients at least one or more materials selected from a gallium nitride, an indium nitride, and an aluminum nitride is formed on the substrates 33, for example, such as sapphire etc. of which a substrate surface is the C plane (namely, direction where C axis is perpendicular to a substrate surface), by methods, such as the MOCVD method, or the MOVPE method, or the other CVD methods, or the Chloride VPE method, or the MBE method, etc.

In addition, a substrate 33 is used as a substrate 30 for light emitting device production as it is.

What usually formed the GaN thin film of an amorphous by the thickness of about 100 A-2000 A as a buffer thin film layer 31 is used.

On the buffer layer 31, the thin film layer 34-2 which has the N type or the P type semiconductor characteristic and is constituted by the epitaxially grown thin film which comprises as the main ingredients at least one or more materials selected from a gallium nitride, an indium nitride, and an aluminum nitride, is formed by methods, such as the MOCVD method, or the MOVPE method, or the other CVD methods, or the Chloride VPE method, or the MBE method.

The thin film layer 34-2 is a contact layer for connecting with an electrode electrically and applying potential to a luminescence layer.

What formed the epitaxially grown single crystal GaN thin film which has the N type semiconductor characteristic that Si etc. was usually doped as a thin film layer 34-2 by the thickness of about 0.5 μm-20 μm is used.

On the luminescence layer 34-2, the thin film layer 34-1 which has the N type or the P type semiconductor characteristic and is constituted by the epitaxially grown thin film which comprises as the main ingredients at least one or more materials selected from a gallium nitride, an indium nitride, and an aluminum nitride by methods, such as the MOCVD method, or the MOVPE method, or the other CVD methods, or the Chloride VPE method, or the MBE method, is formed.

The thin film layer 34-1 is one of the cladding layers which sandwich a luminescence layer.

What formed the epitaxially grown single crystal AlGaN thin film which has the N type semiconductor characteristic that Si etc. was usually doped as a thin film layer 34-1 by the thickness of about 0.02 μm-1.0 μm is used.

The thin film layer 34-1 and the thin film layer 34-2 have the same semiconductor characteristic of type.

On the thin film layer 34-1, the luminescence layer 36 which undoped, or doped only Zn, or doped only Si, or doped Zn and Si simultaneously and is constituted by the epitaxially grown thin film which comprises as the main ingredients at least one or more materials selected from a gallium nitride, an indium nitride, and an aluminum nitride by methods, such as the MOCVD method, or the MOVPE method, or the other CVD methods, or the Chloride VPE method, or the MBE method, is formed.

For example, when the light emitting device of double hetero structure is produced, as the luminescence layer 36 usually, what formed the thin film of the epitaxially grown single crystal InGaN mixture composition which is undoped one or containing the above-mentioned doping ingredient by the thickness of about 50 A-5000 A is used.

The wavelength of the light emitted from a luminescence layer changes with the kinds of InGaN compositions or doping ingredients, that is, luminescence wavelength is about 450 nm (blue) by composition of undoped In0.20Ga0.80N, luminescence wavelength is about 390 nm (purple) by composition of undoped In0.06Ga0.94N, luminescence wavelength is about 450 nm (blue) in composition of only a Zn doping, or Zn and Si simultaneously doping of In0.06Ga0.94N. On the luminescence layer 36, the thin film layer 35-1 which has the P type or the N type semiconductor characteristic and is constituted by the epitaxially grown thin film which comprises as the main ingredients at least one or more materials selected from a gallium nitride, an indium nitride, and an aluminum nitride by methods, such as the MOCVD method, or the MOVPE method, or the other CVD methods, or the Chloride VPE method, or the MBE method, is formed. The thin film layer 35-1 is adjusted to the P type semiconductor characteristic when the thin film layer 34-1 is N type semiconductor, the thin film layer 35-1 is adjusted to the N type semiconductor characteristic when the thin film layer 34-1 is P type semiconductor.

The thin film layer 35-1 functions as a cladding layer which sandwiches a luminescence layer.

What formed the thin film of the epitaxially grown single crystal AlGaN mixture composition which has the P type semiconductor characteristic that Mg etc. was usually doped as a thin film layer 35-1 by the thickness of about 0.02 μm-1.0 μm is used. On the thin film layer 35-1, the thin film layer 35-2 which has the same semiconductor characteristic of type as the thin film layer 35-1 constituted from the epitaxially grown thin film which comprises as the main ingredients at least one or more materials selected from a gallium nitride, an indium nitride, and an aluminum nitride by methods, such as the MOCVD method, or the MOVPE method, or the other CVD methods, or the Chloride VPE method, or the MBE method, is formed.

The thin film layer 35-2 functions as a contact layer.

What formed the epitaxially grown single crystal GaN thin film which has the P type semiconductor characteristic that Mg etc. was usually doped as a thin film layer 35-2 by the thickness of about 0.05 μm-5 μm is used.

The electrode 38 which comprised Ti/Al or Ni/Au is formed on the thin film layer 34-2 and the thin film layer 35-2.

The light emitting device shown in FIG. 41 in which the luminescence layer 36 is inserted into the two-layer semiconductor thin film layer 34-1, 34-2 and the two-layer semiconductor thin film layers 35-1, and 35-2, has double hetero structure.

The light emitting device which has the structure in which a cladding layer of the above-mentioned thin film layer 34-1 and thin film layer 35-1 is formed furthermore in the state of two layers, and in which the luminescence layer is sandwiched by a total of a three-layer thin film layer, respectively including the contact layer is also producible.

That is, as such an example, for example, there are the thin film of the InGaN mixture composition which doped Si etc. to the luminescence layer side and the thin film of the AlGaN mixture composition which doped Si etc. to the contact layer side as the thin film layer 34-1, the thin film of the InGaN mixture composition which doped Mg etc. to the luminescence layer side and the thin film of the AlGaN mixture composition which doped Mg etc. to the contact layer side as the thin film layer 35-1, and what comprised two layers at a time, respectively, etc.

In addition, in the case of the light emitting device which emits light with short wavelength, such as a purple-blue color, purple, or ultraviolet rays, in order that the thin film layer 34-2, the thin film layer 35-1, and the thin film layer 35-2 may lessen absorption of luminescence as much as possible, not only what is 100 mol % GaN but also what is formed from the mixed composition AlGaN of AIN and GaN is suitably used as the main ingredients.

Donor formation doping ingredients, such as Si, Ge, Se, Te, and O, and acceptor formation doping ingredients, such as Mg, Be, Ca, Zn, Cd, and C, will make a thin film into N type semiconductor or P type semiconductor, furthermore, what kind of rate can also make these contain to the main ingredients in order to make electric resistivity of this thin film small, but it is preferred that they are contained usually in the range of 0.00001-10 mol %.

It is illustrated in FIG. 41, the conventional light emitting device 37 of the double hetero structure has been formed by the substrate 33 which consists of sapphire etc., buffer layer 31, the thin film layer 34-2 which has N type semiconductor characteristic (or the thin film layer which has P type semiconductor characteristic), the thin film layer 34-1 which has N type semiconductor characteristic (or the thin film layer which has P type semiconductor characteristic), luminescence layer 36, the thin film layer 35-1 which has P type semiconductor characteristic (or the thin film layer which has N type semiconductor characteristic), the thin film layer 35-2 which has P type semiconductor characteristic (or the thin film layer which has N type semiconductor characteristic), and electrode 38.

A light emitting device drives and emits light by applying direct-current electric power to an electrode 38.

The luminous efficiency of the above-mentioned conventional light emitting device of double hetero structure which is produced by using substrates, such as sapphire etc., is usually about 2%-8%.

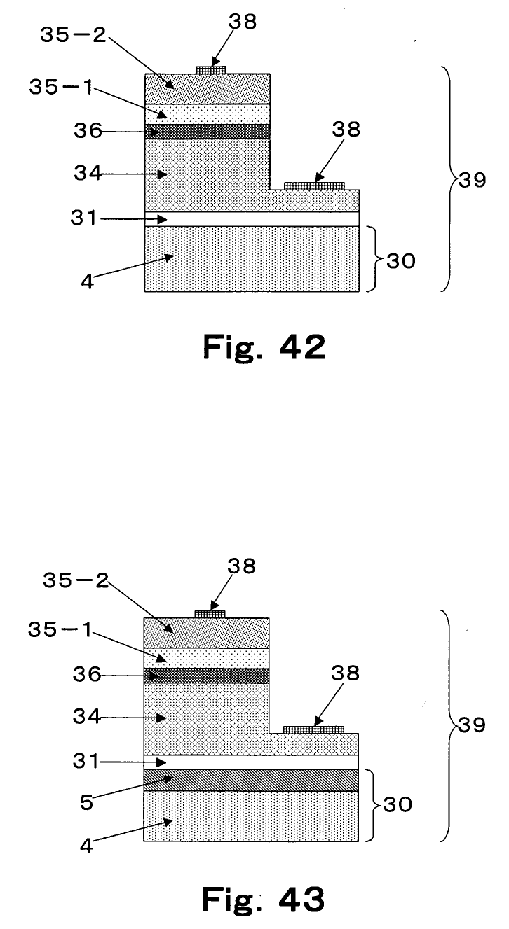

FIG. 42-FIG. 61 show the example figures of the light emitting device according to this invention which is produced using the sintered compact which comprises a ceramic material as the main ingredients, such as the sintered compact comprising an aluminum nitride as the main ingredients, the sintered compact comprising a ceramic material having the crystal structure of a hexagonal system or a trigonal system as the main ingredients, and the sintered compact comprising a ceramic material as the main ingredients and forming the thin film comprising at least one or more materials selected from a gallium nitride, an indium nitride, and an aluminum nitride as the main ingredients, etc.

In FIG. 42-FIG. 61, there shows situations, wherein the above-mentioned sintered compacts which comprise as the main ingredients each ceramic material are made into a substrate, and a light emitting device is constituted by laminating N type semiconductor layer, luminescence layer, and P type semiconductor layer which consist of a thin film which comprises as the main ingredients at least one or more materials selected from a gallium nitride, an indium nitride, and an aluminum nitride and which is the basic element of a light emitting device onto this substrate.

FIG. 42 is a sectional view showing one example of the light emitting device according to this invention using the substrate which consists of a sintered compact which comprises a ceramic material as the main ingredients as a substrate for light emitting device production as it is, instead of conventional substrates, such as sapphire etc.

Namely, in FIG. 42, there shows a situation in which the light emitting device 39 according to this invention is formed in the same thin film constitution as what was shown in FIG. 40 using the sintered compact which comprises a ceramic material as the main ingredients as a substrate 30 for light emitting device production as it is.

In FIG. 42, substrate 4 which consists of a sintered compact which comprises a ceramic material as the main ingredients is itself used as a substrate 30 for light emitting device production. In the light emitting device according to this invention illustrated in FIG. 42, the thin film layer 34, the thin film layer 35-1, the thin film layer 35-2, and the luminescence layer 36 can be formed usually as a single crystal which grew epitaxially in order to raise the luminous efficiency of a light emitting device, respectively.

What has the crystallinity in which the half width of the rocking curve of the X ray diffraction line from the lattice plane of the Miller Index (002) of this thin film is not more than 3600 seconds, usually not more than 300 seconds, and furthermore not more than 100 seconds, can be formed.

Although it is preferred that the thin film layer 34, the thin film layer 35-1, and the thin film layer 35-2 are usually in a single crystal state altogether, when the thin film layer 35-2 and the thin film layer 34 consist of two or more layers, the contact layer for electrode connection may not necessarily be the crystallized state of not a single crystal state but an amorphous state, a polycrystal, and an orientated polycrystal in two layers.

As for the luminous efficiency of the above-mentioned light emitting device according to this invention which is illustrated in FIG. 42 and is produced using the substrate which consists of a sintered compact which comprises a ceramic material as the main ingredients, it is usually not less than 8%, and is superior to the luminous efficiency of the conventional light emitting device produced using substrates, such as sapphire etc.

When the sintered compact which comprises an aluminum nitride as the main ingredients is used as a substrate 4, the light emitting device which has luminous efficiency at least not less than 10% can be produced.

FIG. 43 is a sectional view showing one example of the light emitting device according to this invention, in which the substrate which consists of a sintered compact which comprises a ceramic material as the main ingredients and which formed at least one layer of thin films which comprise as the main ingredients at least one or more materials selected from a gallium nitride, an indium nitride, and an aluminum nitride is used as a substrate for light emitting device production, instead of conventional substrates, such as sapphire etc.

That is, in FIG. 43, there shows situation, in which the substrate 4 which consists of a sintered compact which comprises a ceramic material as the main ingredients and which formed the thin film 5 which comprises as the main ingredients at least one or more materials selected from a gallium nitride, an indium nitride, and an aluminum nitride is used as a substrate 30 for light emitting device production, and the light emitting device 39 according to this invention is formed in the same thin film constitution as what was shown in FIG. 40.

What has at least one of the crystallized states selected from a single crystal, an amorphous state, a polycrystal, and an orientated polycrystal is usually used as the thin film 5.

In FIG. 43, the substrate 30 for light emitting device production is constituted with the substrate 4 which consists of a sintered compact which comprises a ceramic material as the main ingredients, and the thin film 5 formed on this substrate 4.

In the light emitting device according to this invention illustrated in FIG. 43, the thin film layer 34, the thin film layer 35-1, the thin film layer 35-2, and the luminescence layer 36 can be formed usually as a single crystal which grew epitaxially in order to raise the luminous efficiency of a light emitting device, respectively.

What has the crystallinity in which the half width of the rocking curve of the X ray diffraction line from the lattice plane of the Miller Index (002) of this thin film is not more than 3600 seconds, usually not more than 300 seconds, and furthermore not more than 100 seconds, can be formed.

Although it is preferred that the thin film layer 34, the thin film layer 35-1, and the thin film layer 35-2 are usually in a single crystal state altogether, when the thin film layer 35-2 and the thin film layer 34 consist of two or more layers, the contact layer for electrode connection may not necessarily be the crystallized state of not a single crystal state but an amorphous state, a polycrystal, and an orientated polycrystal in two layers.

The luminous efficiency of the above-mentioned light emitting device according to this invention which is illustrated in FIG. 43 and is produced using the substrate which consists of a sintered compact which comprises a ceramic material as the main ingredients is usually not less than 8%, and is superior to the luminous efficiency of the conventional light emitting device produced using substrates, such as sapphire etc.

When the sintered compact which comprises an aluminum nitride as the main ingredients is used as a substrate 4, the light emitting device which has luminous efficiency at least not less than 10% can be produced.

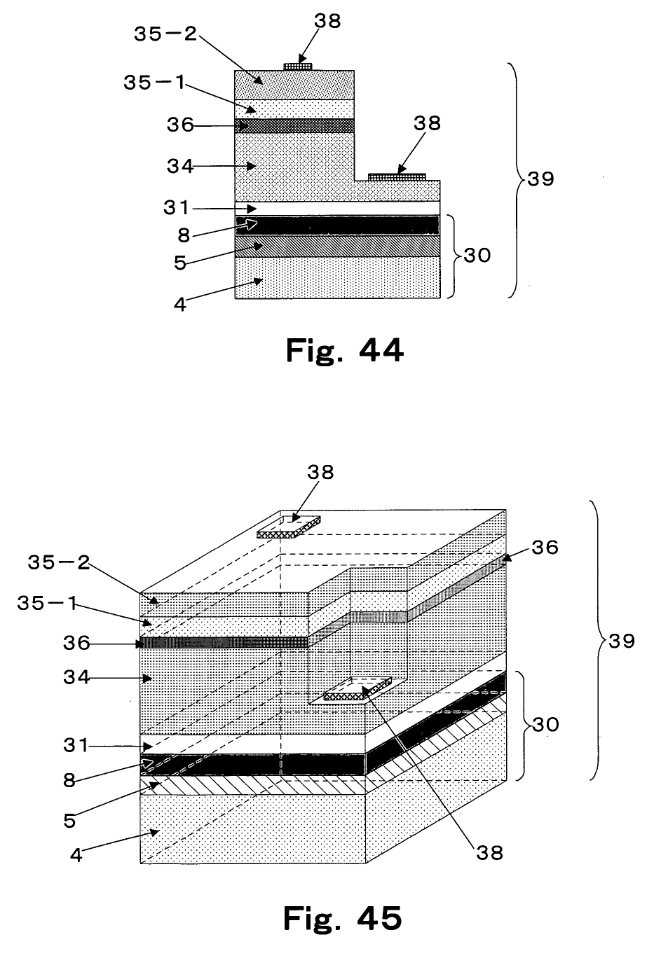

FIG. 44 is a sectional view showing one example of the light emitting device according to this invention in which what formed at least two or more layers of thin films which comprise as the main ingredients at least one or more materials selected from a gallium nitride, an indium nitride, and an aluminum nitride onto the substrate which consists of a sintered compact which comprises a ceramic material as the main ingredients is used as a substrate for light emitting device production, instead of conventional substrates, such as sapphire etc.

That is, in FIG. 44, there shows situation, in which the substrate 4 which consists of a sintered compact which comprises a ceramic material as the main ingredients and which formed at least two or more layers of thin films is used as a substrate 30 for light emitting device production, forming the thin film 5 which comprises as the main ingredients at least one or more materials selected from a gallium nitride, an indium nitride, and an aluminum nitride onto the substrate 4 and forming furthermore the thin film 8 which comprises as the main ingredients at least one or more materials selected from a gallium nitride, an indium nitride, and an aluminum nitride onto it, and the light emitting device 39 is formed in the same thin film constitution as what was shown in FIG. 40.

What is at least one of the crystallized states which are selected from a single crystal, an amorphous state, a polycrystal, and an orientated polycrystal is used usually, as for the thin film 5 and thin film 8.

Usually, as for the thin film 8, it is preferred to use what is a single crystal state.

In that case, as a thin film 5 it is preferred to use what is at least one of the crystallized states which are selected from an amorphous state, a polycrystal, and an orientated polycrystal, and further it is more preferred to use what is an orientated polycrystalline state.

In FIG. 44, the substrate 30 for light emitting device production is constituted with the substrate 4 which consists of a sintered compact which comprises a ceramic material as the main ingredients, the thin film 5 formed on this substrate 4, and the thin film 8.

In the light emitting device according to this invention illustrated in FIG. 44, the thin film layer 34, the thin film layer 35-1, the thin film layer 35-2, and the luminescence layer 36 can be formed usually as a single crystal which grew epitaxially in order to raise the luminous efficiency of a light emitting device, respectively.

As for the crystallinity, as half width of the rocking curve of the X ray diffraction line from the lattice plane of the Miller Index (002) of this thin film, what is not more than 3600 seconds, what is not more than 300 seconds usually, and what is furthermore not more than 100 seconds can be formed.

Although it is preferred that the thin film layer 34, the thin film layer 35-1, and the thin film layer 35-2 are usually in a single crystal state altogether, when the thin film layer 35-2 and the thin film layer 34 consist of two or more layers, the contact layer for electrode connection may not necessarily be the crystallized state of not a single crystal state but an amorphous state, a polycrystal, and an orientated polycrystal in two layers.

The luminous efficiency of the above-mentioned light emitting device according to this invention which is illustrated in FIG. 44 and which is produced using the substrate which consists of a sintered compact which comprises a ceramic material as the main ingredients is usually not less than 8%, and is superior to the luminous efficiency of the conventional light emitting device produced using substrates, such as sapphire etc.

When the sintered compact which comprises an aluminum nitride as the main ingredients is used as a substrate 4, the light emitting device which has luminous efficiency at least not less than 10% can be produced.

FIG. 45 is a perspective diagram showing one example of situation that the light emitting device according to this invention shown as a sectional view in FIG. 44 was seen aslant.

FIG. 45 is shown as an example in which the substrate which consists of a sintered compact which comprises a ceramic material as the main ingredients and which formed at least two or more layers of thin films which comprise as the main ingredients at least one or more materials selected from a gallium nitride, an indium nitride, and an aluminum nitride is used as a substrate for light emitting device production, instead of conventional substrates, such as sapphire etc.

In FIG. 45, situations in which a part of comer of the thin film layer 34 is removed by etching etc. and the electrode 38 is formed small are shown.

Other electrodes 38 are small formed in the portion of the comer of the thin film layer 35-2.

The light emitting device which comprises such electrode arrangement is used for the light emitting diode (LED) in which luminescence is usually performed from the whole luminescence layer surface.

When an electrode is small formed in the portion of the comer of a thin film layer etc. as illustrated in FIG. 45, or it is although it is not indicated in FIG. 45, when an electrode is formed covering a large area of the thin film layer 34 and the thin film layer 35-2 in order to raise electric connection, it is preferred to constitute an electrode so that luminescence may be emitted as much as possible to the exterior of the device, as luminescence from the whole luminescence layer surface is not intercepted as much as possible with an electrode by making an electrode thin to the thickness by which luminescence from a luminescence layer can be penetrated.

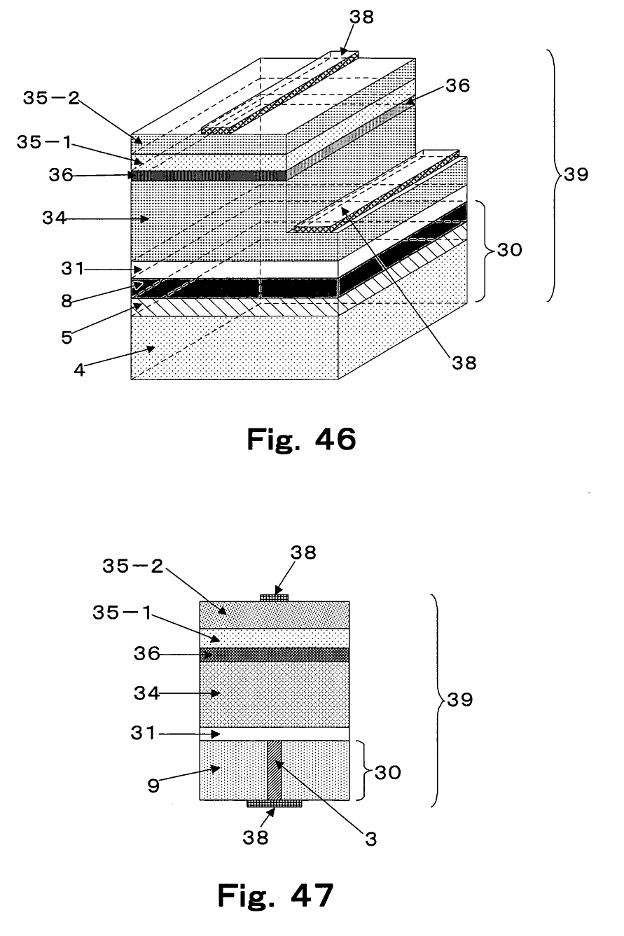

FIG. 46 is a perspective diagram showing one example of situations in which the light emitting device according to this invention shown as a sectional view in FIG. 44 was seen aslant.

FIG. 46 is shown as an example in which the substrate which consists of a sintered compact which comprises a ceramic material as the main ingredients and which formed at least two or more layers of thin films which comprise as the main ingredients at least one or more materials selected from a gallium nitride, an indium nitride, and an aluminum nitride is used as a substrate for light emitting device production, instead of conventional substrates, such as sapphire etc.

FIG. 46 shows the example of a light emitting device in which electrode arrangement of the light emitting device according to this invention shown in FIG. 45 is not small formed in the corner of a thin film layer, but formed beltlike over the whole thin film layer.

In FIG. 46, all the portions of one side of the thin film layer 34 are removed by etching etc., the electrode 38 is formed beltlike, and another electrode 38 is also formed beltlike on the thin film layer 35-2.

The light emitting device which comprises such electrode arrangement is usually used as a laser diode (LD) in which multiple reflection of the light is carried out within the luminescence layer of the portion immediately under the electrode formed in the thin film layer 35-2, so luminescence is performed only in the fixed direction with high energy from a luminescence layer like laser light.

When forming the light emitting device of the structure illustrated in FIG. 46 as a laser diode, what consists of a sintered compact which comprises an aluminum nitride as the main ingredients as a ceramic substrate 4 which constitutes the substrate 30 for light emitting device production is preferred.

Namely, when a laser diode is produced using conventional substrates, such as sapphire etc., in order to mitigate a lattice mismatching, or a disagreement of thermal expansion coefficient etc., between a substrate and the thin films which comprise as the main ingredients at least one or more materials selected from a gallium nitride, an indium nitride, and an aluminum nitride, the method, so-called ELO (Epitaxially Lateral Over-growth) method, in which the thin film portion with few dislocation, cracks, etc., is used as a material which functions as a laser diode, is used in many cases, such that the thin film which comprises as the main ingredients at least one or more materials selected from a gallium nitride, an indium nitride, and an aluminum nitride is formed anew on the thin film, such as SiO₂, formed beforehand beltlike, but on the other hand, if what consists of a sintered compact which comprises an aluminum nitride as the main ingredients is used as a substrate 4, regardless of the specific place of this thin film, even if it is used at any portion of this thin film, there is effect with which the laser diode excellent in luminous efficiency is producible, because the lattice mismatching or the disagreement of thermal expansion coefficient, etc. is small between a substrate and the thin films which comprise as the main ingredients at least one or more materials selected from a gallium nitride, an indium nitride, and an aluminum nitride, and this thin film with few dislocation and cracks which comprises as the main ingredients at least one or more materials selected from a gallium nitride, an indium nitride, and an aluminum nitride can be formed directly on the substrate without forming the thin film, such as SiO₂, as indicated in FIG. 46.

As for a laser diode, although what has a high output and a long life is easy to obtain by what is the structure which is formed as sandwiches a luminescence layer by the thin film layer of super lattice structure in which tens of or more layers the thin film of AlGaN mixture composition of not more than 100 A and a GaN thin film not more than 100 A with thin thickness are laminated is made into N type and P type semiconductor respectively, but in this invention, especially when the sintered compact which comprises an aluminum nitride as the main ingredients is used as a substrate for light emitting device production, the laser diode with high luminous efficiency, a high output, and a long life is producible, even if the thin film layer of this super lattice structure does not use but a cladding layer or a contact layer other than the luminescence layer of multi-quantum-well structure comprises a thin film of a single layer, respectively as well as the laser diode produced using the thin film layer of such super lattice structure.

Also in the light emitting device of the structure illustrated in FIG. 46, it is preferred that they are the single crystal thin film which comprises as the main ingredients at least one or more materials selected from a gallium nitride, an indium nitride, and an aluminum nitride as a thin film layer 8 formed in a substrate.

In that case, it is preferred to use what has at least one of the crystallized states selected from an amorphous state, a polycrystal, and an orientated polycrystal as a thin film 5, further, it is more preferred to use what has an orientated polycrystalline state.

When forming the light emitting device of the structure illustrated in FIG. 46 as a laser diode, it is preferred to use not the single quantum well structure that consists of a well layer of one layer of thin films as a luminescence layer but the multi-quantum-well structure which repeated and laminated the well layer and the barrier layer.

When forming a light emitting device as a laser diode, what was multilayered, respectively and formed suitably the thin film layer 34, the thin film layer 35-1, the thin film layer 34-2, etc. is used.

FIG. 47 is a sectional view showing one example of the light emitting device according to this invention in which the substrate which consists of a sintered compact which comprises a ceramic material as the main ingredients and which has a conduction via is used as a substrate for light emitting device production as it is, instead of conventional substrates, such as sapphire.

That is, in FIG. 47, there shows situation, in which the substrate 9 which consists of a sintered compact which comprises a ceramic material as the main ingredients and which has a conduction via 3 is used as a substrate 30 for light emitting device production, and the light emitting device 39 is formed in the same thin film constitution as what was shown in FIG. 40.

In FIG. 47, substrate 9 which consists of a sintered compact which comprises a ceramic material as the main ingredients and has a conduction via 3 is itself used as a substrate 30 for light emitting device production.

In the case of the light emitting device according to this invention which is illustrated in FIG. 47 and is produced using the substrate 9 which consists of a sintered compact which comprises a ceramic material as the main ingredients and which has the conduction via 3, it is not necessary to remove a part of thin film layer 34 by etching etc. in order to form an electrode, the light emitting device of a constitution of that the electrode has been arranged at the upper and lower sides which formed the electrode 38 in the ceramic substrate 9 is producible, as shown in FIG. 42-FIG. 46.

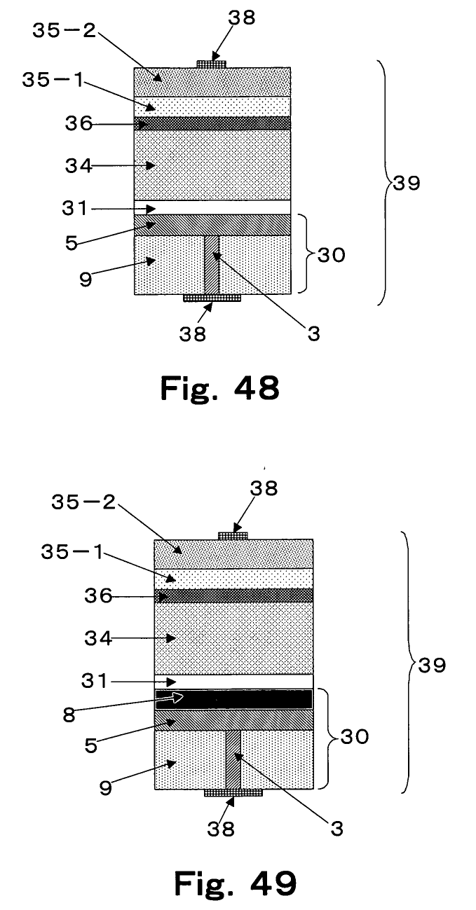

FIG. 48 is a sectional view showing one example of the light emitting device according to this invention in which the substrate which consists of a sintered compact which comprises a ceramic material as the main ingredients and has a conduction via and which formed at least one layer of thin films which comprise as the main ingredients at least one or more materials selected from a gallium nitride, an indium nitride, and an aluminum nitride is used as a substrate for light emitting device production, instead of conventional substrates, such as sapphire.

That is, in FIG. 48, there shows situation, in which the substrate 9 which consists of a sintered compact which comprises a ceramic material as the main ingredients and has a conduction via 3 and which formed the thin film 5 which comprises as the main ingredients at least one or more materials selected from a gallium nitride, an indium nitride, and an aluminum nitride is used as a substrate 30 for light emitting device production, and the light emitting device 39 is formed in the same thin film constitution as what was shown in FIG. 40.

The thin film 5 is usually used at least one of the crystallized states selected from a single crystal, an amorphous state, a polycrystal, and an orientated polycrystal.

In FIG. 48, the substrate 9 which consists of a sintered compact which comprises a ceramic material as the main ingredients and has a conduction via 3 and which formed the thin film 5 which comprises as the main ingredients at least one or more materials selected from a gallium nitride, an indium nitride, and an aluminum nitride is used as a substrate 30 for light emitting device production.

In the case of the light emitting device according to this invention which is illustrated in FIG. 48 and is produced using the substrate 9 which consists of a sintered compact which comprises a ceramic material as the main ingredients and which has the conduction via 3, by making a thin film 5 into conductivity, it is not necessary to remove a part of thin film layer 34 by etching etc. as shown in FIG. 42-FIG. 46 in order to form an electrode, the light emitting device of a constitution of that the electrode has been arranged at the upper and lower sides which formed the electrode 38 in the ceramic substrate 9 is producible by making a thin film 5 into having a conductivity.

FIG. 49 is a sectional view showing one example of the light emitting device according to this invention in which the substrate which consists of a sintered compact which comprises a ceramic material as the main ingredients and has a conduction via and which formed at least two layers of thin films which comprise as the main ingredients at least one or more materials selected from a gallium nitride, an indium nitride, and an aluminum nitride is used as a substrate for light emitting device production, instead of conventional substrates, such as sapphire.

That is, in FIG. 49, there shows situation, in which the substrate 9 which consists of a sintered compact which comprises a ceramic material as the main ingredients and has a conduction via 3 and which formed at least two or more layers of thin films is used as a substrate 30 for light emitting device production, forming the thin film 5 which comprises as the main ingredients at least one or more materials selected from a gallium nitride, an indium nitride, and an aluminum nitride onto the substrate 9 and forming furthermore the thin film 8 which comprises as the main ingredients at least one or more materials selected from a gallium nitride, an indium nitride, and an aluminum nitride onto it, and the light emitting device 39 is formed in the same thin film constitution as what was shown in FIG. 40.

The thin film 5 is usually used at least one of the crystallized states selected from a single crystal, an amorphous state, a polycrystal, and an orientated polycrystal.

In FIG. 49, as for what formed at least two or more layers of thin films in which the thin film 8 which comprises as the main ingredients at least one or more materials selected from a gallium nitride, an indium nitride, and an aluminum nitride is formed furthermore on it after the thin film 5 which comprises as the main ingredients at least one or more materials selected from a gallium nitride, an indium nitride, and an aluminum nitride was formed on the substrate 9 which consists of a sintered compact which comprises a ceramic material as the main ingredients and has a conduction via 3, it is used as a substrate 30 for light emitting device production.

In the case of the light emitting device according to this invention which is illustrated in FIG. 49 and is produced using the substrate 9 which consists of a sintered compact which comprises a ceramic material as the main ingredients and which has the conduction via 3, by making a thin film 5 and a thin film 8 into conductivity, it is not necessary to remove a part of thin film layer 34 by etching etc. as shown in FIG. 42-FIG. 46 in order to form an electrode, the light emitting device of a constitution of that the electrode has been arranged at the upper and lower sides which formed the electrode 38 in the ceramic substrate 9 is producible.

In the light emitting device according to this invention which is illustrated in FIG. 47-FIG. 49 and is produced using the substrate which consists of a sintered compact which comprises a ceramic material as the main ingredients and has a conduction via, the thin film layer 34, the thin film layer 35-1, the thin film layer 35-2, and the luminescence layer 36 can be formed usually as a single crystal which grew epitaxially in order to raise the luminous efficiency of a light emitting device, respectively.

As for the crystallinity, as half width of the rocking curve of the X ray diffraction line from the lattice plane of the Miller Index (002) of this thin film, what is not more than 3600 seconds, what is not more than 300 seconds usually, and what is furthermore not more than 100 seconds can be formed.

Although it is preferred that the above-mentioned thin film layer 34, the thin film layer 35-1, and the thin film layer 35-2 are usually in a single crystal state altogether, when the thin film layer 35-2 and the thin film layer 34 consist of two or more layers, the contact layer for electrode connection may not necessarily be the crystallized state of not a single crystal state but an amorphous state, a polycrystal, and an orientated polycrystal in two layers.

The luminous efficiency of the above-mentioned light emitting device according to this invention which is illustrated in FIG. 47-FIG. 49 and is produced using the substrate which consists of a sintered compact which comprises a ceramic material as the main ingredients and has a conduction via is usually not less than 8%, and is superior to the luminous efficiency of the conventional light emitting device produced using substrates, such as sapphire.

When the sintered compact which comprises an aluminum nitride as the main ingredients as a substrate 9 is used, the light emitting device which has luminous efficiency at least not less than 10% can be produced.

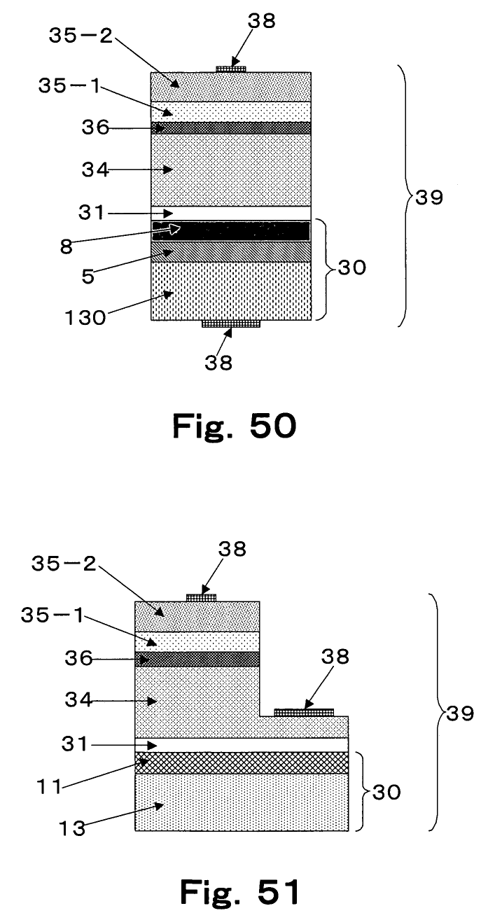

FIG. 50 is a sectional view showing one example of the light emitting device according to this invention in which the thing whose at least two layers of thin films which comprise as the main ingredients at least one or more materials selected from a gallium nitride, an indium nitride, and an aluminum nitride was formed on the substrate which consists of a sintered compact which has conductivity and comprises a ceramic material as the main ingredients is used as a substrate for light emitting device production, instead of conventional substrates, such as sapphire.

That is, in FIG. 50, there shows situation, in which the substrate 130 which consists of a sintered compact which comprises a ceramic material as the main ingredients and has conductivity and which formed at least two or more layers of thin films is used as a substrate 30 for light emitting device production, forming the thin film 5 which comprises as the main ingredients at least one or more materials selected from a gallium nitride, an indium nitride, and an aluminum nitride onto the substrate 130 and forming furthermore the thin film 8 which comprises as the main ingredients at least one or more materials selected from a gallium nitride, an indium nitride, and an aluminum nitride onto it, and the light emitting device 39 is formed in the same thin film constitution as what was shown in FIG. 40.

The thin film 5 is usually used at least one of the crystallized states selected from a single crystal, an amorphous state, a polycrystal, and an orientated polycrystal.

In FIG. 50, as for what formed at least two or more layers of thin films in which the thin film 8 which comprises as the main ingredients at least one or more materials selected from a gallium nitride, an indium nitride, and an aluminum nitride is formed furthermore on it after the thin film 5 which comprises as the main ingredients at least one or more materials selected from a gallium nitride, an indium nitride, and an aluminum nitride was formed on the substrate 130 which consists of a sintered compact which comprises a ceramic material as the main ingredients and has conductivity, it is used as a substrate 30 for light emitting device production.

In the case of the light emitting device according to this invention which is illustrated in FIG. 50 and is produced using the substrate 130 which consists of a sintered compact which comprises a ceramic material as the main ingredients and which has conductivity, by making a thin film 5 and a thin film 8 into conductivity, it is not necessary to remove a part of thin film layer 34 by etching etc. as shown in FIG. 42-FIG. 46 in order to form an electrode, the light emitting device of a constitution of that the electrode has been arranged at the upper and lower sides which formed the electrode 38 in the ceramic substrate 9 is producible.

As for the electric resistivity in room temperature of the above-mentioned sintered compact which comprises as the main ingredients a ceramic material as the main ingredients and has a conductivity, what is not more than 1×10² Ω·cm is usually used.

In order to supply electric power to a luminescence layer in the state with as much as possible little loss, what is not more than 1×10¹ Ω·cm is preferred, what is not more than 1×10⁰ Ω·cm is more preferred, what is not more than 1×10⁻¹ Ω·cm is still more preferred, what is not more than 1×10⁻² Ω·cm is the most preferred, as the electric resistivity in room temperature. For example, what consists of a sintered compact which comprises a zinc oxide as the main ingredients can be used as a substrate 130 which consists of a sintered compact with a conductivity which comprises a ceramic material as the main ingredients.

In the case of the sintered compact which comprises a zinc oxide as the main ingredients, what has not more than 1×10² Ω·cm of electric resistivity in room temperature can be obtained comparatively easily by adding an aluminum ingredient or transition metal ingredients, such as iron or chromium, or by adding the above-mentioned transition metal ingredient simultaneously with an aluminum ingredient or simultaneously with a rare earth element ingredient.

Since what is not more than 1×10¹ Ω·cm, what is not more than 1×10⁰ Ω·cm, what is not more than 1×10⁻¹ ohm, and what is furthermore not more than 1×10⁻² Ω·cm can also be obtained comparatively easily as electric resistivity in room temperature, it is desirable.

In the case of the sintered compact which comprises a zinc oxide as the main ingredients, what has optical permeability simultaneously with a conductivity is obtained as it became clear according to this invention, since it can use as a substrate for producing the light emitting device of the up-and-down electrical connection type electrode arrangement which was excellent in luminous efficiency, it is desirable.

In the light emitting device according to this invention which is illustrated in FIG. 50 and is produced using the substrate which consists of a sintered compact which comprises a ceramic material as the main ingredients and which has conductivity, the thin film layer 34, the thin film layer 35-1, the thin film layer 35-2, and the luminescence layer 36 can be formed usually as a single crystal which grew epitaxially in order to raise the luminous efficiency of a light emitting device, respectively.

As for the crystallinity, as half width of the rocking curve of the X ray diffraction line from the lattice plane of the Miller Index (002) of this thin film, what is not more than 3600 seconds, what is not more than 300 seconds usually, and what is furthermore not more than 100 seconds can be formed.

Although it is preferred that the above-mentioned thin film layer 34, thin film layer 35-1, and thin film layer 35-2 are usually in a single crystal state altogether, when the thin film layer 35-2 and the thin film layer 34 consist of two or more layers, the contact layer for electrode connection may not necessarily be the crystallized state of not a single crystal state but an amorphous state, a polycrystal, and an orientated polycrystal in two layers.

The luminous efficiency of the above-mentioned light emitting device according to this invention which is illustrated in FIG. 50 and is produced using the substrate which consists of a sintered compact which comprises a ceramic material as the main ingredients and which has conductivity is usually not less than 8%, and is superior to the luminous efficiency of the conventional light emitting device produced using substrates, such as sapphire.

FIG. 51 is a sectional view showing one example of the light emitting device according to this invention, wherein what formed at least one layer of thin film conductivity material which comprises as the main ingredients a material, such as various metals, an alloy, a metal nitride, a metal carbide, and a metal silicide, onto the substrate which consists of a sintered compact which comprises as the main ingredients an aluminum nitride was used as a substrate for light emitting device production instead of conventional substrates, such as sapphire.

That is, in FIG. 51, situations in which what formed the thin film conductivity material 11 on the substrate 13 which consists of a sintered compact which comprises an aluminum nitride as the main ingredients is used as a substrate 30 for light emitting device production, and others, the light emitting device 39 is formed of the same thin film constitution as what was shown in FIG. 40 are shown.

In FIG. 51, what formed the thin film conductivity material 11 on the substrate 13 which consists of a sintered compact which comprises an aluminum nitride as the main ingredients is used as a substrate 30 for light emitting device production.

In case of the light emitting device according to this invention which is illustrated in FIG. 51 and is produced using the substrate 13 which consists of a sintered compact which comprises an aluminum nitride as the main ingredients in which the thin film conductivity material 11 was formed, luminescence from a light emitting device becomes hard to be emitted from a substrate 13 by using this thin film conductivity material 11 as a reflective material, since it becomes easy to be emitted to the exterior of the device from the upper direction of this substrate 13, the light emitting device as which directivity control of luminescence is required, such as, for example, the light emitting diode used for a surface emission-type laser or a flat panel display etc., can be produced, it is desirable.

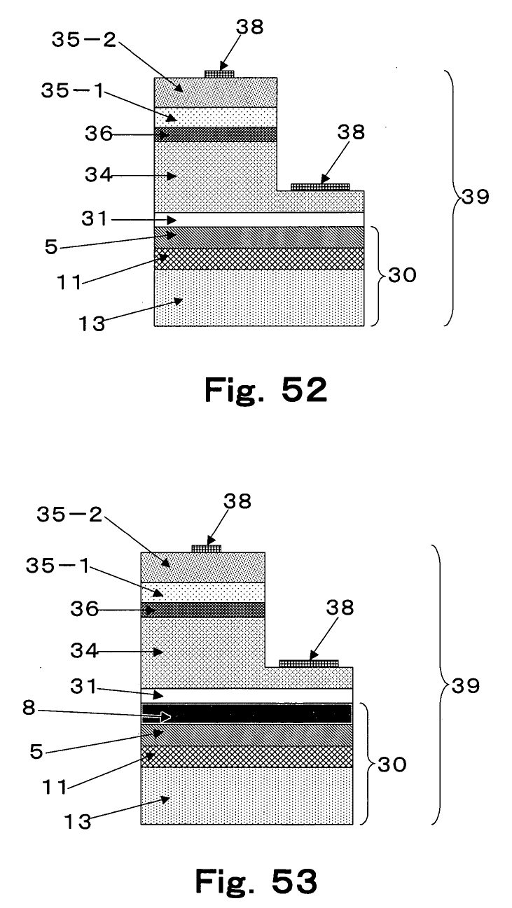

FIG. 52 is the sectional view showing one example of the light emitting device according to this invention produced using like FIG. 43 and FIG. 48 what formed at least one layer of thin films which comprise as the main ingredients at least one or more materials selected from a gallium nitride, an indium nitride, and an aluminum nitride onto the substrate 13 which consists of a sintered compact which comprises an aluminum nitride as the main ingredients and formed the thin film conductivity material 11, as a substrate 30 for light emitting device production.

The effect at the time of using the thin film conductivity material 11 as a reflective material is the same as that of the light emitting device illustrated in FIG. 51.

FIG. 53 is the sectional view showing one example of the light emitting device according to this invention produced using what formed at least two or more layers of thin films as a substrate 30 for light emitting device production, like FIG. 44, FIG. 49, and FIG. 50, wherein at least one layer of thin films which comprise as the main ingredients at least one or more materials selected from a gallium nitride, an indium nitride, and an aluminum nitride is formed on the substrate 13 which consists of a sintered compact comprising an aluminum nitride as the main ingredients and which formed the thin film conductivity material 11 shown in FIG. 51, and the thin film which comprises as the main ingredients at least one or more materials selected from a gallium nitride, an indium nitride, and an aluminum nitride is formed furthermore on it.

About the effect at the time of using the thin film conductivity material 11 as a reflective material, it is the same as that of the light emitting device illustrated in FIG. 51.

In the light emitting device according to this invention produced using the substrate which consists of a sintered compact which comprises an aluminum nitride as the main ingredients in which the thin film conductivity material illustrated in FIG. 51-FIG. 53 was formed, the thin film layer 34, the thin film layer 35-1, the thin film layer 35-2, and the luminescence layer 36 can be formed usually as a single crystal which grew epitaxially in order to raise the luminous efficiency of a light emitting device, respectively.

As for the crystallinity, as half width of the rocking curve of the X ray diffraction line from the lattice plane of the Miller Index (002) of this thin film, what is not more than 3600 seconds, what is not more than 300 seconds usually, and what is furthermore not more than 100 seconds can be formed.

Although it is preferred that the above-mentioned thin film layer 34, thin film layer 35-1, and thin film layer 35-2 are usually in a single crystal state altogether, when the thin film layer 35-2 and the thin film layer 34 consist of two or more layers, the contact layer for electrode connection may not necessarily be the crystallized state of not a single crystal state but an amorphous state, a polycrystal, and an orientated polycrystal in two layers.

The luminous efficiency of the light emitting device which is illustrated in FIG. 51-FIG. 53 and is produced using the substrate which consists of a sintered compact which comprises an aluminum nitride as the main ingredients and which formed the thin film conductivity material is usually not less than 8%, and is superior to the luminous efficiency of the conventional light emitting device produced using substrates, such as sapphire.

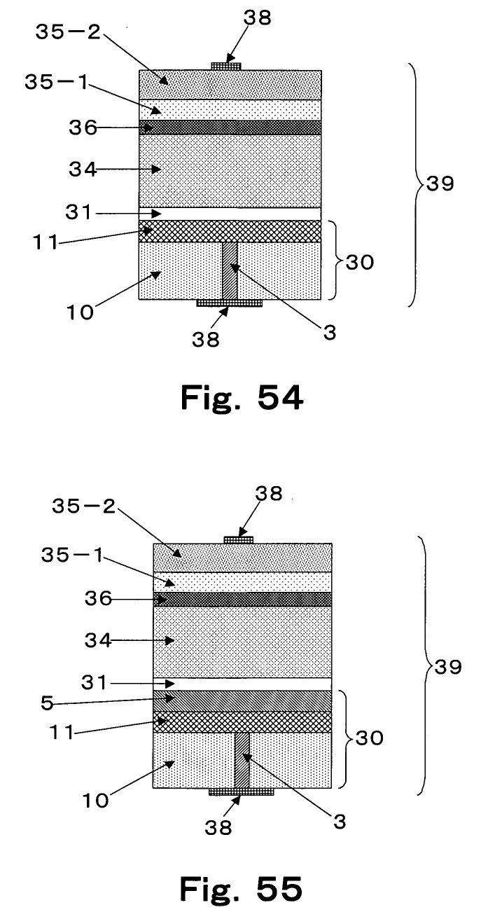

FIG. 54-FIG. 56 is the sectional view showing the example of the light emitting device according to this invention produced using what formed the thin film conductivity material 11 shown in FIG. 51-FIG. 53 onto the substrate 10 which consists of a sintered compact which comprises an aluminum nitride as the main ingredients and which has a conduction via 3, as a substrate 30 for light emitting device production.

In FIG. 54-FIG. 56, the effect of forming a conduction via 3 is that the light emitting device which has arranged the electrode up and down is producible, since it is not necessary to remove a part of thin film layer 34 by etching etc., and to form an electrode like the light emitting device illustrated in FIG. 47-FIG. 49.

Moreover, by forming the thin film conductivity, also there is an effect in which the electric connection with the buffer layer 31, the thin film layer 34, and the luminescence layer 36 of a light emitting device which are formed on this thin film conductivity material material 11 are becoming easy to improve.

FIG. 54 shows one example of the light emitting device according to this invention produced using what formed the thin film conductivity material 11 onto the substrate 10 which consists of a sintered compact which comprises an aluminum nitride as the main ingredients and which has a conduction via 3, as the substrate 30 for light emitting device production as it is.

FIG. 55 shows one example of the light emitting device according to this invention produced using what formed like FIG. 43, FIG. 48, and FIG. 52 at least one layer of thin film which comprises as the main ingredients at least one or more materials selected from a gallium nitride, an indium nitride, and an aluminum nitride onto the thin film conductivity material 11 formed on the substrate 10 which consists of a sintered compact which comprises an aluminum nitride as the main ingredients and which has a conduction via 3, as a substrate 30 for light emitting device production.

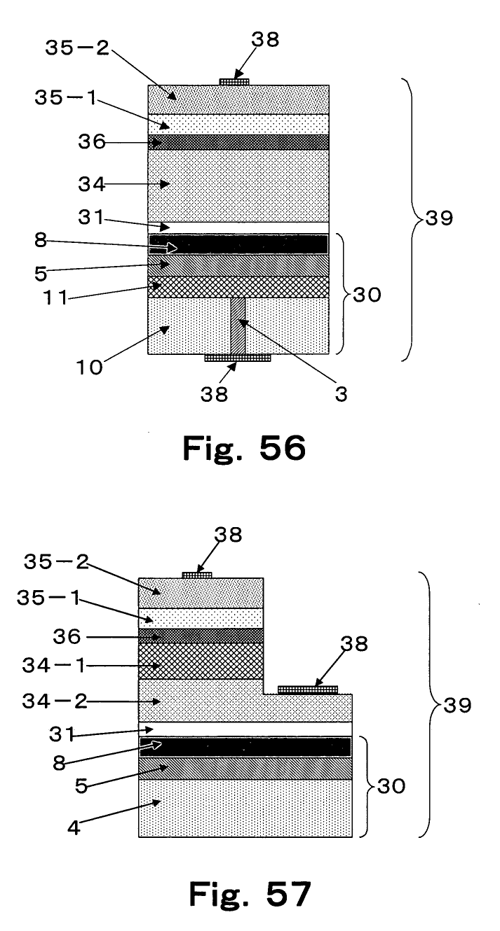

FIG. 56 shows one example of the light emitting device according to this invention produced using what formed at least two layers of thin films as a substrate 30 for light emitting device production, like FIG. 44 , FIG. 49, FIG. 50, and FIG. 53, wherein the thin film conductivity material 11 was formed on the substrate 10 which consists of a sintered compact which comprises an aluminum nitride as the main ingredients and which has a conduction via 3, at least one layer of thin film which comprises as the main ingredients at least one or more materials selected from a gallium nitride, an indium nitride, and an aluminum nitride was formed on it, and the thin film which comprises as the main ingredients at least one or more materials selected from a gallium nitride, an indium nitride, and an aluminum nitride was formed furthermore on it.

In the light emitting device illustrated in FIG. 54-FIG. 56, about the effect at the time of using the thin film conductivity material 11 as a reflective material, it is the same as that of the light emitting device illustrated in FIG. 51.

In the light emitting device according to this invention produced using the substrate which consists of a sintered compact which comprises an aluminum nitride as the main ingredients and has a conduction via and which formed the thin film conductivity material and is illustrated in FIG. 54-FIG. 56, the thin film layer 34, the thin film layer 35-1, the thin film layer 35-2, and the luminescence layer 36 can be usually formed as a single crystal which grew epitaxially in order to raise the luminous efficiency of a light emitting device, respectively.

As for the crystallinity, as half width of the rocking curve of the X ray diffraction line from the lattice plane of the Miller Index (002) of this thin film, what is not more than 3600 seconds, what is not more than 300 seconds usually, and what is furthermore not more than 100 seconds can be formed.

Although it is preferred that the above-mentioned thin film layer 34, thin film layer 35-1, and thin film layer 35-2 are usually in a single crystal state altogether, when the thin film layer 35-2 and the thin film layer 34 consist of two or more layers, the way of the contact layer for electrode connection may not necessarily be the crystallized state of not a single crystal state but an amorphous state, a polycrystal, and an orientated polycrystal between two layers.

The luminous efficiency of the light emitting device produced using the substrate which consists of a sintered compact which comprises an aluminum nitride as the main ingredients and has a conduction via and which formed the thin film conductivity material and is illustrated in FIG. 54-FIG. 56 is usually not less than 8%, and is superior to the luminous efficiency of the conventional light emitting device produced using substrates, such as sapphire.

In this invention, a light emitting device is producible using the substrate which consists of various sintered compacts which formed the thin film conductivity material and which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., and other than these, the sintered compact which formed the thin film conductivity material and which comprises as the main ingredients various ceramic materials, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc., by replacing the above-mentioned substrate which consists of a sintered compact which comprises an aluminum nitride as the main ingredients and is shown in FIG. 51-FIG. 56 and which formed the thin film conductivity material.

As for the light emitting device produced using the substrate which consists of a sintered compact which comprises a ceramic material as the main ingredients other than such sintered compact which comprises an aluminum nitride as the main ingredients, luminescence from a light emitting device becomes hard to be emitted from a substrate side by using this thin film conductivity material as a reflective material, since it becomes easy to be emitted to the exterior of the device from the upper direction of this substrate, the light emitting device as which directivity control of luminescence is required, such as, for example, the light emitting diode used for a surface emission-type laser or a flat panel display etc., can be produced, it is desirable.

FIG. 57 is the sectional view showing an example in which the thin film layer 34 is formed in two layers of the thin film layer 34-1 and the thin film layer 34-2 in the light emitting device in this invention shown in FIG. 44.

The thin film layer 34-2 is usually used as a contact layer connected with an electrode 38.

The light emitting device which consists of a constitution illustrated in FIG. 57 can be produced as light emitting devices with double hetero structure, or with single quantum well structure, or with multi-quantum-well structure.

In the case of the light emitting device with double hetero structure, the thin film layer 34-1 is used as a cladding layer which sandwiches the luminescence layer 36 with the thin film layer 35-1.

When the light emitting device which consists of a constitution illustrated in FIG. 57 is produced as a light emitting device with single quantum well structure, this thin film layer 34-1 is used as a barrier layer of the luminescence layer 36 which functions as a well layer.

FIG. 58 is the sectional view showing an example, wherein in the light emitting device according to this invention shown in FIG. 57, the thin film layer 34-1 is formed in two layers of the thin film layer 34-1-1 and the thin film layer 34-1-1, and the thin film layer 35-1 is formed furthermore in two layers of the thin film layer 35-1-1 and the thin film layer 35-1-2.

The light emitting device which consists of a constitution illustrated in FIG. 58 can be produced as light emitting devices with double hetero structure, or with single quantum well structure, or with multi-quantum-well structure, in which two layers of cladding layers which have N type and P type semiconductor characteristic are formed at a time, respectively

In the case of the light emitting device with double hetero structure, the thin film layer 34-1-1 and the thin film layer 34-1-2 are used as a cladding layer which sandwiches the luminescence layer 36 with the thin film layer 35-1-1 and the thin film layer 35-1-2.

When the light emitting device which consists of a constitution illustrated in FIG. 58 is produced as a light emitting device with single quantum well structure, this thin film layer 34-1-1 and the thin film layer 35-1-1 are used as a barrier layer of the luminescence layer 36 which functions as a well layer.

The light emitting device which consists of the thin film with multilayer constitution which grew epitaxially which comprises as the main ingredients at least one or more materials selected from a gallium nitride, an indium nitride, and an aluminum nitride as shown in FIG. 58 is producible as a laser diode with the multi-quantum-well layer structure which carried out multilayer lamination of a well layer and the barrier layer as a luminescence layer, respectively.

In this invention, the light emitting device is being constituted by lamination of at least three or more layers of N type semiconductor layer, a luminescence layer, and P type semiconductor layer with the shape of an epitaxially grown thin film which comprises as the main ingredients at least one or more materials selected from a gallium nitride, an indium nitride, and an aluminum nitride.

The sizes of the outside of a light emitting device are about 0.05 mm square −10 mm square, usually are in the range of about 0.1 mm square −3 mm square, although the thickness of each thin film layer which constitutes a light emitting device differs in each thin film layer and it is in the range of about 0.005 μm-20 μm respectively, in the state where each thin film layer was multilayered and it became a light emitting device, the total of the thickness is about 0.5 μm-50 μm, usually it is in the range of about 1 μm-20 μm.

Usually, the luminescence layer of a light emitting device is plane form, and it is considered that the light which was emitted from this luminescence layer is irradiated to the substrate surface which keeps about 0.5 μm-50 μm distance, and confronts each other perpendicularly.

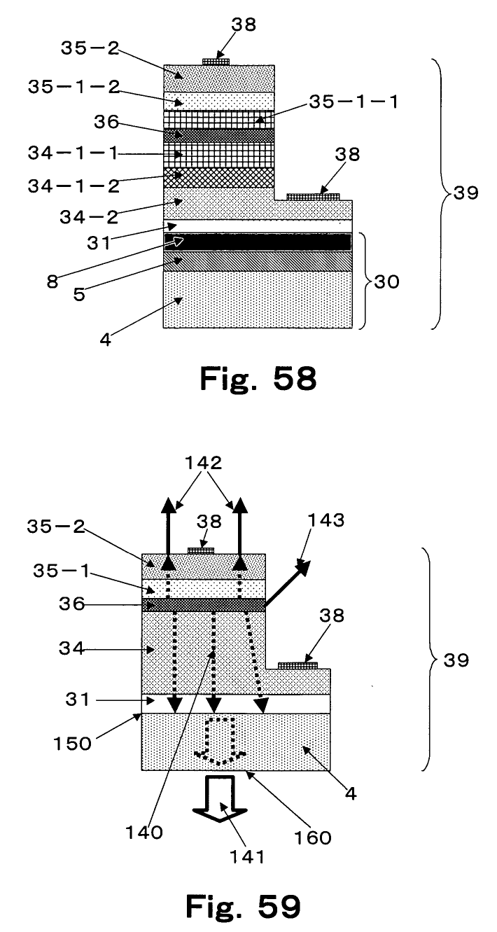

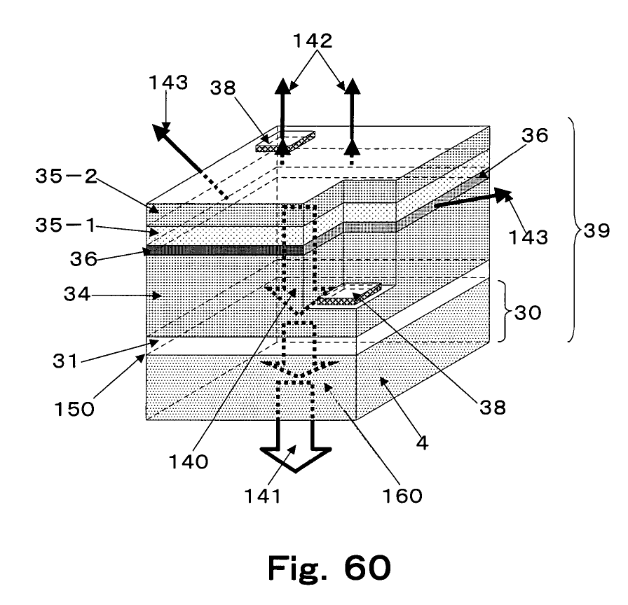

FIG. 59 and 60 show this situation typically.

FIG. 59 is a sectional view which guessed the discharge situation of the light emitted from the luminescence layer of the light emitting device shown in FIG. 42, and filled it in typically. FIG. 60 is what guessed the discharge situation of the light emitted from the luminescence layer of the light emitting device currently drawn as a perspective diagram, and filled it in typically as shown in FIG. 45.

In FIG. 59 and FIG. 60, the luminescence layer 36 of a light emitting device 39 is usually formed in the shape of a plane, it is guessed that a part of the light 140 emitted from the luminescence layer 36 is irradiated from across to the surface of a substrate 4 which confronts each other perpendicularly and which consists of a sintered compact which comprises ceramics as the main ingredients.

If a substrate 4 is sapphire at this time, many of light 140 emitted from the luminescence layer 36 will be reflected in the interface 150 of the thin film layer 31 (or thin film layer 34) and substrate 4 which are formed on a substrate 4 and it will return to a thin film layer or a luminescence layer, it is confined in the thin film layer 31, the thin film layer 34, the thin film layer 35-1, the thin film layer 35-2, or the luminescence layer 36, and is not emitted to the exterior of a light emitting device, as for the light emitted from a luminescence layer, only the part is mainly emitted to the device exterior as an emitted light 142 from the thin film layer 35-2.

Therefore, what has low luminous efficiency is seemed.

On the other hand, if the substrate 4 is the sintered compact which comprises an aluminum nitride as the main ingredients, the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., or in addition to this, the various sintered compacts which consist of a ceramic material according to this invention, many of light 140 emitted from the luminescence layer 36 in the interface 150 of the thin film layer 31 (or thin film layer 34) and a substrate 30 is not reflected, further, when the substrate 4 has optical permeability, it penetrates this substrate and it is emitted to the exterior of a light emitting device as an emitted light 141.

In addition, a part of light emitted from a luminescence layer is emitted as an emitted light 142 from the thin film layer 35-2, and a part is emitted to the device exterior as an emitted light 143 from the side of a luminescence layer.

Therefore, it seems that the luminous efficiency of the light emitting device which produced using such substrate which consists of a sintered compact which comprises ceramics as the main ingredients becomes high if it is compared with the case where a sapphire substrate is used.

It is surmised that such phenomenon is produced in the interface of the substrate 4 which consists of a sintered compact which comprises ceramics as the main ingredients and the thin film 5, even if one layer of thin films of a thin film 5, or two layers of thin films of a thin film 5 and a thin film 8 are formed on the substrate 4 which is illustrated in FIG. 43 and 44 and which consists of a sintered compact which comprises ceramics as the main ingredients.

Namely, even if a thin film is the light emitting device produced using as a substrate the thing whose at least one layer or two or more layers of thin films are formed on the above-mentioned substrate 4 which consists of a sintered compact comprising ceramics as the main ingredients and is illustrated in FIG. 43 and 44, it is guessed that if it is compared with the luminous efficiency of the light emitting device produced by using conventional substrates, such as sapphire etc., luminous efficiency becomes equivalent, or not less than 2-3 times, or not less than 3-4 times, or a maximum of not less than 4-5 times like the thing in which this thin film is not formed and which was illustrated in FIG. 42.

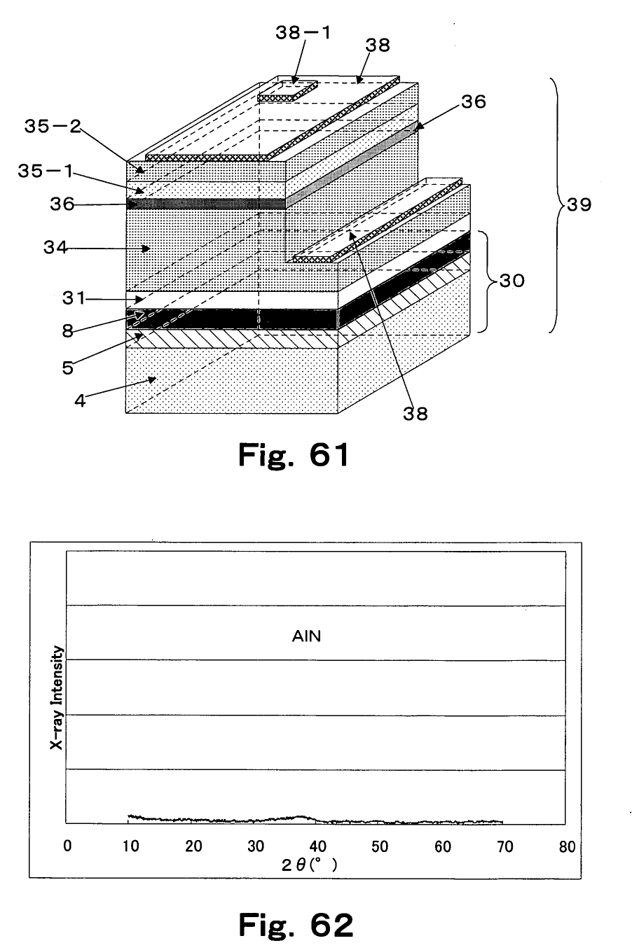

In addition, FIG. 61 is shown as an example of the light emitting device according to this invention which formed the electrode covering a large area.

FIG. 61 is a perspective diagram showing one example of situations in which the light emitting device according to this invention shown as a sectional view in FIG. 44 is seen aslant.

FIG. 61 is shown as an example in which what formed at least two layers of thin films which comprise as the main ingredients at least one or more materials selected from a gallium nitride, an indium nitride, and an aluminum nitride onto the substrate which consists of a sintered compact which comprises a ceramic material as the main ingredients was used as a substrate for light emitting device production instead of conventional substrates, such as sapphire.

In FIG. 61, situations in which a part of comer of the thin film layer 34 is removed by etching etc., and the electrode 38 is formed widely beltlike are shown.

Another electrode 38 is formed covering a large area on the thin film layer 35-2.

There is an advantage of becoming easy to supply large current to a luminescence layer in the condition of low loss, by using such large electrode.

When producing a light emitting device using the electrode with a large area, it is preferred to use a transparent electrode or the electrode with optical permeability so that luminescence from a luminescence layer may not be intercepted as much as possible with an electrode.

As for this transparent electrode or the electrode with optical permeability, it is preferred to use what has a transparency or optical permeability at least to the light emitted from a light emitting device.

Therefore, as an electrode, it is preferred to use a conductive material which has a transparency or optical permeability at least to the light with a wavelength not more than 550 nm.

When the material which cannot usually penetrate light easily, such as metal, an alloy, etc., is used as an electrode, it is preferred to generate transparency or optical permeability by making the thickness into at least not more than 100 nm, preferably not more than 10 nm.

In order to raise the electric power supply to the electrode formed in the above-mentioned large area, it is also effective to form the terminal 38-1 independently for electric power supplies on an electrode using the material which is excellent in conductivity.

The luminous efficiency of the light emitting device according to this invention is influenced by the existence of the thin film which comprises as the main ingredients at least one or more materials selected from a gallium nitride, an indium nitride, and an aluminum nitride and is formed beforehand on the substrate which consists of various sintered compacts which comprise a ceramics material as the main ingredients, or the crystallized state of this thin film, as mentioned above.

Furthermore, although the luminous efficiency of the light emitting device according to this invention is influenced also according to the quality of the material (main ingredient), composition, purity, optical permeability, size of a sintered compact crystal grain, and existence of conduction via, surface smooth nature of the case using as a substrate the various sintered compacts which comprise a ceramic material, and thickness of this substrate, etc., in the various sintered compacts which comprise a ceramic material and is used as a substrate, what is at least equivalent if it is compared with the luminous efficiency of the light emitting device produced using the conventional substrates, such as sapphire etc., or not less than 2-3 times, or not less than 3-4 times, or a maximum of not less than 4-5 times can be provided.

Thus, an optical waveguide with less transmission loss of ultraviolet rays than the optical waveguide produced using the conventional sapphire substrate or LiNbO₃ substrate, etc. can be provided now according to this invention.

The light emitting device which excelled the light emitting device produced using a conventional sapphire substrate in luminous efficiency can be provided now.

I can think that the factor which has realized it is that a single crystal thin film with high crystallinity which comprises as the main ingredients at least one or more materials selected from a gallium nitride, an indium nitride, and an aluminum nitride is able to have been formed on it not using a homogeneous single crystal substrate but using various sintered compacts which comprise a ceramic material as the main ingredients and which consists of a grain boundary phase etc. by a crystal grain, a grain boundary, or an additive etc.

It can also consider that it is a big factor that high junction nature has been realized between the thin film which comprises as the main ingredients at least one or more materials selected from a gallium nitride, an indium nitride, and an aluminum nitride and includes this single crystal thin film and the substrate, or between these thin films.

As such sintered compact, what comprises an aluminum nitride as the main ingredients, or what comprises as the main ingredients various ceramic materials which have the crystal structure of a hexagonal systems or a trigonal system, such as silicon carbide, silicon nitride, beryllium oxide, a zinc oxide, and an aluminum oxide, can be used suitably.

In addition to this, even if it uses the substrate which consists of various sintered compacts which comprise as the main ingredients a ceramic material, such as a zirconium dioxide, a magnesium oxide, a magnesium aluminate, a titanium oxide, a barium titanate, a lead titanate zirconate, a yttrium oxide, a thorium dioxide, a ferrite, a mullite, a forsterite, a steatite, and glass ceramics etc., a light emitting device excellent in luminous efficiency can be produced.

Since what comprises an aluminum nitride as the main ingredients in each above-mentioned sintered compact as a substrate for light emitting device production has the more excellent luminous efficiency, it is desirable.

It is preferred to use the substrate which consists of a sintered compact which comprises an aluminum nitride as the main ingredients also in an optical waveguide.

The above-explained factor given to the crystallinity of the single crystal thin film formed on the substrate using the above-mentioned various sintered compacts which comprise a ceramic material is summarize below.

(1) The quality of the material of ceramics (the sintered compact which comprises an aluminum nitride as the main ingredients, or the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc., the difference of the fundamental main ingredient)

(2) Composition of ceramics (purity and a content of the main ingredients, and a content of additives or impurities, etc.)

(3) Optical permeability of ceramics

(4) The size of a ceramic particle

(5) Density of ceramics

(6) Thickness of ceramics

(7) The calcination conditions of ceramics

(8) Surface smooth nature of a substrate

(9) The constitution of a thin film (a single layer, or multilayered constitution of two or more layers, etc.)

(10) The crystallized state of the thin film formed beforehand in a substrate

(11) Thickness of a thin film

(12) The formation conditions of a thin film (methods for forming thin film, such as MOCVD, Chloride VPE, or sputtering etc., substrate temperature, etc.)

The following points are mentioned as a factor which cannot affect the crystallinity of the thin film formed on a ceramic substrate not much easily.

(13) The conduction via is formed or not formed in the sintered compact (irrespective of whether the conduction via is formed into the sintered compact, the thin film with comparatively excellent crystallinity can be formed on this substrate which consists of a sintered compact).

(14) Composition of a thin film (if it is the composition which comprises as the main ingredients at least one or more materials selected from a gallium nitride, an indium nitride, and an aluminum nitride, no matter it may be what combination, the thin film with comparatively excellent crystallinity can be formed and, even if various doping ingredients are included in the thin film, the thin film with comparatively excellent crystallinity can be formed.)

As for the thin film which comprises as the main ingredients at least one or more materials selected from a gallium nitride, an indium nitride, and an aluminum nitride and has at least one of crystalized states selected from an amorphous state, a polycrystal, an orientated polycrystal, and a single crystal etc., and which is formed on the substrate which consists of a sintered compact which comprises an aluminum nitride as the main ingredients or on the substrate for thin film formation and thin film substrate which used the sintered compact which comprises an aluminum nitride as the main ingredients according to this invention, it can be used also as field emission material and cold cathode.

It has realized only after there was contribution in which the single crystal thin film which has good crystallinity, such that the half width of the rocking curve of the X-ray diffraction line from the lattice plane of the Miller Index (002) of the single crystal thin film which comprises as the main ingredients at least one or more materials selected from a gallium nitride, an indium nitride, and an aluminum nitride is not more than 300 seconds, has been formed on the substrate which comprises an aluminum nitride as the main ingredients and which is conventionally being considered not to carry out the lattice matching with a thin film which comprises as the main ingredients at least one or more materials selected from a gallium nitride, an indium nitride, and an aluminum nitride and has various crystallized states, such as an amorphous state, a polycrystal, an orientated polycrystal, and a single crystal.

Although the performance of field emission material or cold cathode is excellent if it uses for a display so that the luminosity at the time of making a phosphor emit light is high, in this invention, when the aluminum nitride thin film and the thin film which comprises an aluminum nitride as the main ingredients and has various crystallized states, such as an amorphous state, a polycrystal, an orientated polycrystal, and a single crystal, are used for field emission material or cold cathode among the above-mentioned thin films of the various crystallized states containing the single crystal, the high value of not less than 1000 candelas/m2 is easy to be acquired as the luminosity at the time of making a color phosphor color.

When using the above-mentioned thin film of various crystallized states according to this invention such as an amorphous state, a polycrystal, an orientated polycrystal, and a single crystal as field emission material or cold cathode, it is desirable to make this thin film of various crystallized states such as an amorphous state, a polycrystal, an orientated polycrystal, and a single crystal, into N type semiconductor by doping Si, O, etc. in order to make an electron easy to emit.

In this invention, since the field emission material or cold cathode which consists of a thin film which comprises as the main ingredients at least one or more materials selected from a gallium nitride, an indium nitride, and an aluminum nitride and has various crystallized states such as an amorphous state, a polycrystal, an orientated polycrystal, and a single crystal etc., is formed on the substrate which consists of a sintered compact which comprises an aluminum nitride as the main ingredients, realization of a display which has a large-sized size of at least 10 inches or more and is cheap in also cost has been possible, the effect on industry is large.

As mentioned above, this invention is a substrate for forming a thin film which comprises as the main ingredients at least one or more materials selected from a gallium nitride, an indium nitride, and an aluminum nitride and has various crystallized states, such as a single crystal or an amorphous state, a polycrystal, and an orientated polycrystal etc., and the substrate is a sintered compact which comprises an aluminum nitride as the main ingredients, it also includes a thin film substrate in which the thin film comprises as the main ingredients at least one or more materials selected from a gallium nitride, an indium nitride, and an aluminum nitride, and is formed on the sintered compact which comprises an aluminum nitride as the main ingredients.

This thin film substrate can be used for the above-mentioned a substrate for light emitting device production which comprises as the main ingredients at least one or more materials selected from a gallium nitride, an indium nitride, and an aluminum nitride, in addition to this, it is also possible to use for the substrate in which the thin film which comprises as the main ingredients at least one or more materials selected from a gallium nitride, an indium nitride, and an aluminum nitride and which is various crystallized states, such as a single crystal or an amorphous state, a polycrystal, and an orientated polycrystal etc., is used as a surface acoustic wave device material, or the wiring substrate using the single crystal thin film which comprises as the main ingredients at least one or more materials selected from a gallium nitride, an indium nitride, and an aluminum nitride as dielectric material and an insulation material, or the substrate using the single crystal thin film which comprises as the main ingredients at least one or more materials selected from a gallium nitride, an indium nitride, and an aluminum nitride as an optical waveguide, etc.

This invention also includes, for example, the sintered compact of high AIN purity which comprises an aluminum nitride as the main ingredients and which is manufactured and made into high purity by the method in which a contained ingredient is vaporized, removed, and reduced, other than the above-mentioned substrates for single crystal thin film formation, and a single crystal thin film substrate.

By using such sintered compact as a substrate, the thin film more excellent in characteristic which comprises as the main ingredients at least one or more materials selected from a gallium nitride, an indium nitride, and an aluminum nitride and is various crystallized states including the single crystal, such as an amorphous state, a polycrystal, and an orientated polycrystal etc., can be formed.

### EXAMPLE 1

As ceramic raw material powder, what consists of a submicron particle in high purity was prepared such as an aluminum nitride (AlN), a silicon carbide (SiC), a silicon nitride (Si₃N₄), an aluminum oxide (Al₂O₃), a zirconium dioxide (ZrO₂), a zinc oxide (ZnO), a magnesium oxide (MgO), a beryllium oxide (BeO), a magnesium aluminate (MgAl₂O₄: spinel).

Aluminum nitride powder is a grade “F” by Tokuyama Soda Co., Ltd. (present: Tokuyama, Inc.), silicon carbide powder is a grade “OY-15” made by Yakushima Denko Co., Ltd., silicon nitride powder is a grade “SN-E05” by Ube Industries, Ltd., alumina is a grade “AKP-30” by Sumitomo Chemical Co., Ltd., zirconium dioxide is a partially-stabilized-zirconia grade “TZ-3Y” which contains Y₂O₃ 3 mol % as a stabilization agent by TOSOH CORP., zinc oxide is a brand “first grade” by Sakai Chemical Industry Co., Ltd., magnesium oxide is the guaranteed reagent powder by Kanto Kagaku, beryllium oxide and spinel used the powder by Kojundo Chemical Laboratory Co., Ltd.

Purity is not less than 99 weight % as main ingredients, except partially stabilized zirconia.

Oxygen is contained 1.0 weight % in the above-mentioned aluminum nitride powder as main impurities as a result of analysis other than AlN of a main ingredient.

In the case of aluminum nitride powder, in the purity of the above-mentioned materials powder, it is the purity of AlN in the ingredient except oxygen.

1.0 weight % of B4C powder and 1.0 weight % of carbon powder are added to silicon carbide powder, 2.0 weight % of Y₂O₃ powder and 2.0 weight % of Al₂O₃ powder are added to silicon nitride powder, and 1.8 weight % of CaCO₃ powder is added to beryllium oxide powder, then the wet blending by the ethanol as a solvent is carried out by a ball mill for 24 hours, after blending they dried and ethanol was vaporized.

Paraffine wax was added to such powders 5 weight %, the powder for molding was produced, and the disk-like powder compact with a diameter of 25.4 mm×thickness of 1.5 mm and a diameter of 32 mm×thickness of 1.5 mm was acquired by uniaxial press molding.

These powder compacts were fired on the firing conditions shown in Table 1 after degreasing under decompression at 300 degrees C., and the sintered compacts were obtained.

Each relative density of each sintered compacts after firing was not less than 99%.

After carrying out specular surface polish of these obtained sintered compact surfaces using chromic oxide and alumina abradant, ultrasonic washing was carried out with acetone, and the substrates for thin film formation were produced.

The surface roughness of each substrate obtained was shown in Table 1.

Next, the constitution phase of these substrates for thin film formation was investigated by X ray diffraction.

As a result, the X ray diffraction pattern which was shown by the sintered compact obtained by using an aluminum nitride powder as raw material was what comprises AlN (Hexagonal) crystal phase indicated by the JCPDS file number 25-1133 as the main phase.

The X ray diffraction pattern which was shown by the sintered compact obtained by using a silicon carbide powder as raw material was what comprises alpha-SiC (Hexagonal) indicated by the above-mentioned file number 29-1131 as the main phase.

The X ray diffraction pattern which was shown by the sintered compact obtained by using a silicon nitride powder as raw material was what comprises beta-Si₃N₄ (Hexagonal) indicated by the above-mentioned file number 33-1160 as the main phase, and consists of 6.6% of unknown phase in addition to this.

The X ray diffraction pattern which was shown by the sintered compact obtained by using an aluminum oxide powder as raw material was what comprises alpha-Al₂O₃ (Trigonal) indicated by the above-mentioned file number 10-173 as the main phase.

The X ray diffraction pattern which was shown by the sintered compact obtained by using a zirconium dioxide powder as raw material was what comprises ZrO₂ (Tetragonal) indicated by the above-mentioned file number 17-923 as the main phase.

The X ray diffraction pattern which was shown by the sintered compact obtained by using a zinc oxide powder as raw material was what comprises ZnO (Hexagonal) indicated by the above-mentioned file number 36-1451 as the main phase.

The X ray diffraction pattern which was shown by the sintered compact obtained by using a magnesium oxide powder as raw material was what comprises MgO (Cubic) indicated by the above-mentioned file number 4-829 as the main phase.

The X ray diffraction pattern which was shown by the sintered compact obtained by using a beryllium oxide powder as raw material was what comprises BeO (Hexagonal) indicated by the above-mentioned file number 35-818 as the main phase.

The X ray diffraction pattern which was shown by the sintered compact obtained by using a magnesium aluminate powder as raw material was what comprises MgAl₂O₄ (Cubic) indicated by the above-mentioned file number 21-1152 as the main phase.

These obtained sintered compacts were clearly polycrystalline substances in which the direction of the crystal grain of the main ingredient inside a sintered compact is to all directions.

The result of the phase constitution by X ray diffraction of the substrate for thin film formation was shown in Table 1.

Next, the thin films of a gallium nitride, an indium nitride, and an aluminum nitride were directly formed on the substrate surface using each substrate obtained with the MOCVD (Metal Organic Chemical Vapor Deposition growth) equipment by high frequency induction heating.

That is, it heated at 1000 degrees C., having put the produced substrate into the reaction container of the above-mentioned equipment, and flowing hydrogen gas first.

Then, trimethyl gallium (TMG), trimethyl indium (TMI), and trimethyl aluminum (TMA) were used as raw materials for thin film production, hydrogen or nitrogen+hydrogen introduces into the above-mentioned each three kinds of fluid raw materials as career gas, and they were bubbled, each raw materials were introduced to the reaction part in which high frequency induction heating will be carried out with ammonia gas, when forming the gallium nitride (GaN) thin film, the substrate temperature was 1000 degrees C., when forming the indium nitride (InN) thin film, the substrate temperature was 700 degrees C., when forming the aluminum nitride (AlN) thin film, the substrate temperature was 1100 degrees C., when forming the mixed crystal thin film of 50 mol % GaN+50 mol % AlN, the substrate temperature was 1050 degrees C.

The formation rate of a thin film is about 0.2-0.4 μm/hour, 0.2-0.5 μm/hour, 1-3 μm/hour, 0.5-1.5 μm/hour, respectively.

The thickness of each formed thin film is 0.25 μm.

Only in the case of the aluminum nitride thin film which is formed on the substrate which consists of a sintered compact which comprises an aluminum nitride as the main ingredients, what had the thickness of 3 82 m and 6 μm was produced.

Observation of each thin film obtained was performed using the optical microscope and the electron microscope, consequently, a crack was not seen inside thin films, and exfoliation did not be seen in an interface between the thin films and the sintered compact which comprises an aluminum nitride as the main ingredients and other various sintered compacts which comprise a ceramic material as the main ingredients.

Tested by pasting up and tearing off after adhesive tape is pasted up to each thin film obtained, consequently, exfoliation did not be seen in an interface between the thin films and the sintered compact which comprises an aluminum nitride as the main ingredients and other various sintered compacts which comprise a ceramic material as the main ingredients, so thin films have been joined firmly with the sintered compact which comprises an aluminum nitride as the main ingredients, and the other various sintered compacts which comprise a ceramic material as the main ingredients.

The thin film conductivity material of Ti/Pt/Au was formed on each formed above-mentioned thin film, the metal lead was soldered and perpendicular tensile strength was investigated, consequently, it all is not less than 2 Kg/mm², so the sintered compact which comprises an aluminum nitride as the main ingredients and the other various sintered compacts which comprise a ceramic material as the main ingredients are joined firmly with each above-mentioned thin film.

The crystallized state of a thin film was investigated by measuring the X ray diffraction pattern of each thin film using the CuKα line after thin film formation, further, the rocking curve of the X ray diffraction of the Miller Index (002) lattice plane of each thin film was taken, and the half width was measured.

Only in the case of the aluminum nitride thin film with a thickness of 0.25 μm formed on the substrate which consists of a sintered compact which comprises an aluminum nitride as the main ingredients, electron beam diffraction was performed, and it investigated the crystallized state of the thin film.

The result is shown in Table 1.

As showing in Table 1, what was directly formed on the substrate which consists of a sintered compact which comprises as the main ingredients a zirconium dioxide, magnesium oxide, and spinel does not become into single crystal state as a result of X ray diffraction pattern measurement of each thin film.

Since the diffraction line not only from a Miller Index (002) lattice plane but also from a lattice plane (100) has appeared, it is obvious that it is a polycrystal.

In the thin film formed on the other sintered compact substrate, only the diffraction line only from a Miller Index (002) lattice plane does appear, it has been in single crystal state.

Moreover, in any substrate, the half width of the rocking curve of the Miller Index (002) lattice plane of the single-crystalized thin film was not more than 3600 seconds.

In all the sintered compacts in which the thin film has become into single crystal state, as for the formation direction of these single crystal thin films to the substrate, C axis of these single crystal thin films was a perpendicular direction to the substrate surface.

From this experimental result, I can guess that the cause with which a thin film did not become into single crystal state is that the crystal system of a zirconium dioxide is tetragonal (Tetragonal), a magnesium oxide and a spinel are cubic (Cubic).

The main ingredients of other substrates are hexagonal (Hexagonal) altogether except for an aluminum oxide.

Although the above-mentioned crystal system of an aluminum oxide is trigonal system (Trigonal), since the classification as hexagonal is also possible for it, it seems that that the thin film formed directly on it can become into a single crystal state is essentially only the case of the substrate which consists of a sintered compact which comprises as the main ingredients the material of a hexagonal system and the material which can be classified as a hexagonal system.

Clearly from an experimental result, especially the substrate that consists of a sintered compact which comprises an aluminum nitride as the main ingredients in the substrates on which the thin film directly formed has become into single crystal state is excellent.

In almost all the formed thin films, the half width of the rocking curve of the X ray diffraction of a Miller Index (002) lattice plane is as sharp as not more than 300 seconds, and it excels in crystallinity.

As mentioned above, even if the various sintered compacts which comprise a ceramic material as the main ingredients are used as a substrate, it was confirmed that the single crystal thin film which comprises as the main ingredients at least one or more materials selected from a gallium nitride, an indium nitride, and an aluminum nitride can be formed directly on this substrate made from a sintered compact.

The crystallinity of the single crystal thin film produced using the sintered compact which comprises an aluminum nitride as the main ingredients also in it was most excellent.

### EXAMPLE 2

Next, as for the crystallinity of the single crystal thin film which comprises as the main ingredients at least one or more materials selected from a gallium nitride, an indium nitride, and an aluminum nitride and is formed directly on the substrate which consists of a sintered compact which comprises an aluminum nitride as the main ingredients, the influence by the characteristics, such as composition of the sintered compact which comprises an aluminum nitride as the main ingredients, microstructure of a sintered compact, and optical transmissivity etc., was investigated.

The raw material powder for sintered compact production used for the experiment prepared the same high purity aluminum nitride powder grade “F” by Tokuyama Soda Co., Ltd. (present: Tokuyama, Inc.) as having used it in Example 1.

This materials powder is manufactured by the method of oxide reduction.

After additives, such as sintering aids, and a black-ized agent etc., are suitably added to this raw material powder, it mixes by a ball mill with ethanol for 24 hours, and it was dried and ethanol was vaporized, then paraffine wax was added to mixed powder 5 weight %, the powder for molding was produced, and the disk-like powder compact with a diameter of 25.4 mm×thickness of 1.5 mm and a diameter of 32 mm×thickness of 1.5 mm was acquired by uniaxial press molding.

After that, paraffine wax was degreased under decompression at 300 degrees C., the setter made from tungsten is used as an firing implement, normal pressure sintering and atmospheric pressure sintering (gas pressure sintering) were performed surrounding the circumference of the powder compact which is a fired thing with the frame made from tungsten in pure nitrogen atmosphere so that it may not become reduced atmosphere, then the various sintered compacts which comprise an aluminum nitride as the main ingredients were produced.

The various sintered compacts which comprise an aluminum nitride as the main ingredients by the hot pressing and HIP (hot isostatic press: hydrostatic pressure sintering) were also produced.

The details of firing conditions are indicated in Table 2.

The substrate which consists of a sintered compact which comprises an aluminum nitride as the main ingredients was produced by grinding and polishing the obtained sintered compact into a size with a diameter of 25.4 mm×thickness of 0.5 mm.

And, in the inside of obtained various aluminum nitride sintered compacts, ingredients, such as unescapable mixing ingredients, such as oxygen in raw material powder, sintering aids, such as a rare earth element compound and an alkaline-earth-metals compound, alkaline metal, silicon ingredient, molybdenum, tungsten, niobium, titanium, carbon, iron, nickel, etc., are not vaporized and removed almost, almost the same quantity as the inside of a powder compact is existing.

By using such obtained various substrates, a thin film which comprises as the main ingredients a gallium nitride, an indium nitride, and an aluminum nitride was formed on the substrate surface by the method which used the MOCVD (Metal Organic Chemical Vapor Deposition) equipment with the same high frequency induction heating as Example 1.

The mixed crystal thin film of 50 mol % GaN+50 mol % InN was formed with the substrate temperature of 780 degrees C.

It is admited that all the obtained thin films are single crystals by measurement of an X ray diffraction pattern using CuKα characteristic X-rays and electron beam diffraction.

Observation of obtained single crystal thin films was performed using the optical microscope and the electron microscope, consequently, a crack was not seen in the inside of single crystal thin films, and exfoliation at a junction interface between the single crystal thin films and the sintered compact which comprises an aluminum nitride as the main ingredients is not seen.

Tested by pasting up and tearing off after adhesive tape is pasted up to each single crystal thin film obtained, consequently, the exfoliation and destruction at a junction interface between this single crystal thin film and a sintered compact which comprises an aluminum nitride as the main ingredients were not seen.

The thin film conductivity material of Ti/Pt/Au was formed on each formed above-mentioned single crystal thin film, the metal lead was soldered and perpendicular tensile strength was investigated, consequently, it all is not less than 2 Kg/mm², so it has joined firmly between the sintered compact which comprises an aluminum nitride as the main ingredients and each above-mentioned single crystal thin film.

Subsequently, the half width of the rocking curve of the X ray diffraction of a Miller Index (002) lattice plane was measured, and the crystallinity of the above-mentioned single crystal thin film was investigated.

As for the formation direction of these single crystal thin films to the substrate, C axis of these single crystal thin films was perpendicular direction to the substrate surface altogether.

These results were shown in Table 2 and Table 3.

In Table 2, the production conditions and the characteristic of the examined substrate which consists of a sintered compact which comprises an aluminum nitride as the main ingredients were shown.

In Table 3, by using the above-mentioned various substrates which consist of a sintered compact which comprises an aluminum nitride as the main ingredients, composition, film thickness, and crystallinity of the single crystal thin film which comprises as the main ingredients at least one or more materials selected from a gallium nitride, an indium nitride, and an aluminum nitride and was formed on this substrate were shown.

In Table 2 and Table 3, by using the substrate whose optical transmissivity of the sintered compact which comprises an aluminum nitride as the main ingredients is not less than 1%, as for the crystallinity of the single crystal thin film which comprises as the main ingredients at least one or more materials selected from a gallium nitride, an indium nitride, and an aluminum nitride and was formed directly on it, it is shown that the half width of the rocking curve of the X ray diffraction line from the lattice plane of a Miller Index (002) is not more than 300 seconds.

In the sintered compact whose optical transmissivity is not less than 5%, the half width of the rocking curve of the X ray diffraction line from the lattice plane (002) of this single crystal thin film is not more than 240 seconds.

In the sintered compact whose optical transmissivity is not less than 10% and comprises an aluminum nitride as the main ingredients, the half width of the rocking curve of the X ray diffraction line from the lattice plane (002) of this single crystal thin film is not more than 200 seconds.

Moreover, in the sintered compact whose optical transmissivity is not less than 40% and comprises an aluminum nitride as the main ingredients, the half width of the rocking curve of the X ray diffraction line from the lattice plane (002) of this single crystal thin film is not more than 150 seconds.

In measurement of optical transmissivity, a spectrophotometer U-4000 by Hitachi, Ltd. is used, the produced substrate which comprises an aluminum nitride as the main ingredients is put in the integrating sphere, then all of the intensity of the light by which incidence is carried out to this sintered compact and the light which has penetrated are collected and the intensity is measured, thus optical transmissivity was obtained by computing a percentage ratio of the intensity of all penetration light and incidence light.

The value of optical transmissivity is measured using light with a wavelength 605 nm.

In Table 2 and Table 3, in the case of the substrate whose content of a rare earth element and an alkaline-earth metal in a sintered compact is below 25 volume % by oxide conversion respectively, as for the crystallinity of the single crystal thin film formed directly on it and comprises as the main ingredients at least one or more materials selected from a gallium nitride, an indium nitride, and an aluminum nitride, the half width of the rocking curve of the X ray diffraction line from the lattice plane of a Miller Index (002) is not more than 300 seconds.

In the case of a sintered compact whose content is below 12 volume % respectively, the half width of the rocking curve of the X ray diffraction line from the lattice plane (002) of this single crystal thin film is not more than 240 seconds.

In the case of a sintered compact which comprises an aluminum nitride as the main ingredients and whose content is below 12 volume % respectively, the half width of the rocking curve of the X ray diffraction line from the lattice plane (002) of this single crystal thin film is not more than 200 seconds.

In Table 2, in X ray diffraction of the sintered compact which comprises an aluminum nitride as the main ingredients and does not form the single crystal thin film which is used in experiment No.34, 45, 49, 50, 58, and 66, in the case of the sintered compact of experiment No.34 the diffraction line was the polycrystal AlN of the main phase shown in the JCPDS file number 25-1134 and the polycrystal ALON shown in the JCPDS file number 36-50, in the case of No.45 different phases were not detected, it was only the diffraction line of polycrystal AlN shown in the JCPDS file number 25-1134, in the case of the substrate of No.49 the diffraction line of YAlO₃ and Y4Al2O9 were detected besides the above-mentioned AlN, in the case of the substrate of No.50 the diffraction line of YAlO₃, Y4Al2O9, and Y₂O₃ were detected besides the above-mentioned AlN, in the case of the substrate of No.58 the diffraction line of ErAlO₃ and Er4Al2O9 were detected besides the above-mentioned AlN, in the case of the substrate of No.66 the diffraction line of W (tungsten) was detected besides the above-mentioned AlN.

When the content of ALON in the sintered compact of No.34 was calculated by the strongest line peak ratio of the diffraction line of AlN and ALON, it was calculated as 1.4%.

When X ray diffraction of the sintered compact which comprises an aluminum nitride as the main ingredients and does not form the single crystal thin film used in experiment No.37-40 was performed, the diffraction line of polycrystal ALON shown in the JCPDS file number 36-50 was detected besides the diffraction line of polycrystal AlN shown in the JCPDS file number 25-1134.

The ALON content in the sintered compact which is obtained from the intensity ratio of the strongest line (311) of ALON and the strongest line (100) of AlN was calculated as 3.2% in the case of No.37, as 9.6% in the case of No.38, as 19.1%,in the case of No.39, and as 29.4% in the case of No.40 respectively.

In Table 2 and Table 3, as for the crystallinity of the single crystal thin films of a gallium nitride and an aluminum nitride which are directly formed on the substrate which consists of a sintered compact which comprises an aluminum nitride as the main ingredients and which was used in experiment No.61, 62, and 63 containing an alkaline metal or a silicon compound, the half width of the rocking curve of the X ray diffraction line from the lattice plane (002) is not more than 300 seconds.

In Table 2 and Table 3, the optical transmissivity (total transmissivity) of the sintered compact which comprises an aluminum nitride as the main ingredients and was used in experiment No.65, 66, 68, and 70 which is measured by using light with a wavelength 605 nm is shown, though this optical transmissivity is smaller than 1% and the sintered compact of experiment No.65 and 68 and 70 are zero, as for the crystallinity of the single crystal thin film of a gallium nitride and an aluminum nitride directly formed on these substrates, the half width of the rocking curve of the X ray diffraction of a lattice plane (002) is not more than 300 seconds.

In Table 2 and Table 3, in the case of the substrate which is used for the experiment and which consists of a sintered compact which comprises an aluminum nitride as the main ingredients and whose total amount of oxygen is not more than 10 weight %, the half width of the rocking curve of the X ray diffraction line from the lattice plane of the Miller Index (002) of the single crystal thin film which comprises as the main ingredients at least one or more materials selected from a gallium nitride, an indium nitride, and an aluminum nitride and is formed directly on it is not more than 300 seconds.

In the sintered compact whose total amount of oxygen is not more than 5.0 weight %, the half width of the rocking curve of the X ray diffraction line from the lattice plane of the Miller Index (002) of the single crystal thin film which comprises as the main ingredients at least one or more materials selected from a gallium nitride, an indium nitride, and an aluminum nitride is not more than 240 seconds.

Moreover, in the sintered compact whose total amount of oxygen is not more than 3.0 weight %, the half width of the rocking curve of the X ray diffraction line from the lattice plane of the Miller Index (002) of the single crystal thin film which comprises as the main ingredients at least one or more materials selected from a gallium nitride, an indium nitride, and an aluminum nitride is not more than 200 seconds.

In Table 2 and Table 3, in the case of the substrate which is used for the experiment and which consists of a sintered compact which comprises an aluminum nitride as the main ingredients and whose amount of ALON is not more than 20%, the half width of the rocking curve of the X ray diffraction line from the lattice plane of the Miller Index (002) of the single crystal thin film which comprises as the main ingredients at least one or more materials selected from a gallium nitride, an indium nitride, and an aluminum nitride and is formed directly on it is not more than 300 seconds.

Moreover, in the sintered compact whose amount of ALON is not more than 7%, the half width of the rocking curve of the X ray diffraction line from the lattice plane of the Miller Index (002) of the single crystal thin film which comprises as the main ingredients at least one or more materials selected from a gallium nitride, an indium nitride, and an aluminum nitride is not more than 200 seconds.

In Table 2 and Table 3, as for the crystallinity of the single crystal thin film which comprises as the main ingredients at least one or more materials selected from a gallium nitride, an indium nitride, and an aluminum nitride and which is directly formed on the substrate which consists of a sintered compact which comprises an aluminum nitride as the main ingredients and whose relative density is not less than 98%, it is shown that the half width of the X ray rocking curve of the lattice plane of a Miller Index (002) of this single crystal thin film is not more than 300 seconds.

When the relative density of the sintered compact is not less than 99%, the half width of the X ray rocking curve of the lattice plane of the Miller Index (002) of this single crystal thin film is not more than 240 seconds.

When the relative density of the sintered compact is not less than 99.5%, the half width of the X ray rocking curve of the lattice plane of the Miller Index (002) of this single crystal thin film is not more than 200 seconds.

In Table 2 and Table 3, when the size of the pore in the sintered compact used in the experiment is an average of not more than 1 μm, as for the crystallinity of the single crystal thin film which comprises as the main ingredients at least one or more materials selected from a gallium nitride, an indium nitride, and an aluminum nitride, the half width of the X ray rocking curve of the lattice plane of the Miller Index (002) of this single crystal thin film is not more than 300 seconds.

When the size of the pore in the sintered compact is an average of not more than 0.7 μm, the half width of the X ray rocking curve of the lattice plane of the Miller Index (002) of this single crystal thin film is not more than 240 seconds.

When the size of the pore in the sintered compact is an average of not more than 0.5 μm, the half width of the X ray rocking curve of the lattice plane of the Miller Index (002) of this single crystal thin film is not more than 200 seconds.

In Table 2 and Table 3, if firing temperature becomes high and firing time becomes long, the size of the AlN crystal grain in the sintered compact which comprises an aluminum nitride as the main ingredients will tend to increase.

That is, the size of the AlN crystal grain in a sintered compact becomes not less than 8 μm by firing of not less than 3 hours at the temperature not less than 1900 degrees C.

The size of the AlN crystal grain in a sintered compact becomes not less than 15 μm by firing of not less than 6 hours at the temperature not less than 1900 degrees C.

When the size of an AlN crystal grain of the sintered compact which comprises an aluminum nitride as the main ingredients and which was used for the experiment is an average of not less than 1 μm, as for the crystallinity of the single crystal thin film which comprises as the main ingredients at least one or more materials selected from a gallium nitride, an indium nitride, and an aluminum nitride, the half width of the X ray rocking curve of the lattice plane of the Miller Index (002) of this single crystal thin film is not more than 300 seconds.

When the size of an AlN crystal grain of a sintered compact is an average of not less than 5 μm, the half width of the X ray rocking curve of the lattice plane of the Miller Index (002) of this single crystal thin film is not more than 240 seconds.

When the size of an AlN crystal grain of a sintered compact is an average of not less than 8 μm, the half width of the X ray rocking curve of the lattice plane of the Miller Index (002) of this single crystal thin film is not more than 200 seconds.

Moreover, when the size of the AlN crystal grain of a sintered compact is an average of not less than 15 μm, as for the half width of the X ray rocking curve of the lattice plane of the Miller Index (002) of this single crystal thin film, what is not more than 150 seconds is obtained.

In the case of a sintered compact with few AlN contents than 80 volume %, that whose crystallinity of the single crystal thin film formed lowers is seen.

In Table 2 and Table3, in the case of the substrate whose degree of surface smoothness of the sintered compact which comprises an aluminum nitride as the main ingredients and was used for the experiment is the average surface roughness not more than Ra 100 mn, the half width of the rocking curve of the X ray diffraction line from the lattice plane of the Miller Index (002) of the single crystal thin film which comprises as the main ingredients at least one or more materials selected from a gallium nitride, an indium nitride, and an aluminum nitride and is formed directly on it is not more than 300 seconds.

### EXAMPLE 3

High purity aluminum nitride powder grade “H” by Tokuyama Soda Co., Ltd. (present: Tokuyama, Inc.) was prepared as materials powder for sintered compact production which comprises an aluminum nitride as the main ingredients.

This materials powder is manufactured by the method of oxide reductionin.

This materials powder contains oxygen 1.3 weight % as impurities. To this raw material powder, suitably, what added Y₂O₃ powder of 3.3 volume %, what added Er₂O₃ powder of 4.02 volume %, and what added CaCO₃ powder of 0.6 volume % by CaO conversion, were mixed with toluene and iso propyl alcohol by a ball mill for 24 hours, then an acrylics binder was added 12 weight parts to a raw powder materials 100 weight parts, further they were mixed for 12 hours and made into a paste, so the green sheet which has three kinds of compositions with a thickness of 0.75 mm by the doctor blade method was produced.

The sheets with square shape whose one-side is 35 mm were produced from this green sheet, and the circular through holes with the diameter of 25 μm, 50 μm, 250 μm, and 500 μm which penetrate the surface and the back were formed by YAG laser on this sheet.

Next, the paste for conduction via was produced by adding alpha terpineol as a solvent, an acrylic resin as a binder, and using three kinds of powders of pure tungsten and the mixed powder of 50 volume % tungsten +50 volume % copper, and pure copper powder as a conductive ingredient, then it was filled up in the above-mentioned through hole and was dried, after removing a binder suitably in the atmosphere which comprises as the main ingredients nitrogen or nitrogen/hydrogen mixed gas, normal pressure sintering was carried out at 1820 degrees C. in N₂ for 2 hours, the sintered compact which comprises an aluminum nitride as the main ingredients and in which a conduction via was formed in the inside was obtained.

In addition, in performing firing, the degreased substance of the green sheet with which the through hole was filled up with conduction via paste and which is the fired thing was put on the setter made from tungsten, the aluminum nitride powder compact was simultaneously placed besides this fired thing, and the circumference was surrounded by the frame of tungsten.

The metal ingredient in a through hole was enough made dense by sintering or fusion solidification, and conductivity has been generated in it, it was uniting also with the sintered compact which comprises an aluminum nitride as the main ingredients, and was functioning as a conduction via.

A conduction via is exposed by grinding and specular surface polish the obtained sintered compact to a size with a diameter of 25.4 mm×thickness of 0.5 mm, the substrate which consists of a sintered compact which comprises an aluminum nitride as the main ingredients and which has a Ra=26 nm as the degree of surface roughness and has conduction via was produced.

The resistance in the room temperature of a conduction via was measured by 4 terminal method after that, and the electric resistivity in room temperature was computed from the shape of a conduction via.

The size of a conduction via has shrunk after firing and has become the diameter of 20-23 μm, 40-44 μm, 209-215 μm, and 422 μm, respectively.

After forming the single crystal thin film of a gallium nitride directly on one surface of the above-mentioned substrate in which conduction via was formed by the thickness of 0.25 μm by the method using the same MOCVD equipment as what was used in Example 1 and 2, the half width of the rocking curve of the X ray diffraction of the Miller Index (002) lattice plane of this single crystal thin film was measured.

Those results were shown in Table 4.

Observed about the single crystal thin film of the circumference in which the conduction via was formed was performed after single crystal thin film formation, consequently, faults, such as a crack and exfoliation in an interface with a conduction via, were not found, but were in a good appearance state, and it was confirmed that the conduction via using the material according to this invention had good junction nature with a gallium nitride thin film.

All of the half width of the rocking curve of the X ray diffraction of the Miller Index (002) lattice plane of this single crystal thin film was not more than 300 seconds, and the electric resistivity of a conduction via was the range of 2.0×10⁻⁶ Ω·cm-7.7×10⁻⁶ Ω·cm in room temperature.

The thin film which was produced in this Example and comprises a gallium nitride as the main ingredients has conductivity.

An electrical connection exists between this thin film which comprises a gallium nitride as the main ingredients and was produced by using each sintered compact in which the conduction via is being formed, and the conduction via exposed in the substrate surface side in which this thin film is not being formed.

Between the electrical conductive single crystal thin film which comprises a gallium nitride as the main ingredients, and conduction via, though they were created in this Example, not only mechanical junction nature but also electrical connection was confirmed.

### EXAMPLE 4

The sheet with square shape of which one-side is 35 mm was produced from the green sheet produced in Example 3, after removing a binder at 500 degrees C. in air, the sintered compact which comprises an aluminum nitride as the main ingredients was obtained by performing normal pressure sintering at 1800 degrees C. in nitrogen for 1 hour.

The substrate which has a Ra=25 nm as the degree of surface roughness and consists of a sintered compact which comprises an aluminum nitride as the main ingredients was produced by grinding and polishing the obtained sintered compact into a square with one-side of 25.4 mm×thickness of 0.5 mm.

Next, the thin film with a various thickness of 0.7 nm-4200 nm which comprises as the main ingredients at least one or more materials selected from a gallium nitride, an indium nitride, and an aluminum nitride was directly formed on the substrate by using the same MOCVD equipment as what was used in Example 1 and 2.

The mixed thin film of 50 mol % InN+50 mol % AlN was formed under the substrate temperature of 820 degrees C.

Thus, the X ray diffraction pattern by CuKα of the obtained thin film was taken except for 100% aluminum nitride of experiment No.90, consequently, they were a diffraction line from the lattice plane of a Miller Index (002) altogether, and were in the state of a single crystal.

100% aluminum nitride thin film was investigated by electron beam diffraction, consequently, only the diffraction from the lattice plane of a Miller Index (002) appeared, diffraction from the lattice plane of a Miller Index (100) was not recognized, this was also in the state of single crystale.

Next, the half width of the rocking curve of the X ray diffraction of the Miller Index (002) lattice plane of the obtained single crystal thin film was measured.

The result was shown in Table 5.

In all the thickness of a single crystal thin film, the half width of the rocking curve of the X ray diffraction of a Miller Index (002) lattice plane is not more than 300 seconds.

### EXAMPLE 5

As the raw material powder for sintered compact production which comprises an aluminum nitride as the main ingredients, two kinds of aluminum nitride powders (“TOYALNITE” by Toyo Aluminium K.K. and made by Starck Co. in Germany “Grade B”) produced by the direct nitriding method from aluminum metal was prepared besides two kinds of raw materials by the method of aluminum oxide reduction used in Example 1, 2, and 3.

Among these materials, molding and degreasing by the same method as Example 1 were performed using two kinds of raw material powders produced by the direct nitriding method of aluminum metal respectively alone, and by using what mixed respectively 50 weight % of the raw materials produced by the method of an aluminum oxide reduction and by the direct nitriding method of aluminum metal, then six kinds of sintered compacts which comprise an aluminum nitride as the main ingredients were obtained by performing a hot press under 300 Kg/cm² at 1950 degree-C. for 2 hours in nitrogen.

The substrate which consists of a sintered compact which comprises an aluminum nitride as the main ingredients and whose degree of surface roughness is Ra=27 nm was produced by grinding and polishing the obtained sintered compact to a size with a diameter of 25.4 mm×thickness of 0.5 mm.

In the sintered compact in which only “TOYALNITE” was used as raw material, 1.6% of ALON was detected besides AlN which was the main phase by X ray diffraction.

In the sintered compact in which only “Grade B” was used as raw material, 2.2% of ALON was detected besides AlN which was the main phase.

In the sintered compact produced from the mixed raw materials of what was produced by the method of an aluminum oxide reduction and what was produced by the direct nitriding method of aluminum metal, similarly, the main phase is AlN and contains ALON 1.2-1.9%.

All of the relative density of these six kinds of sintered compacts were not less than 98%.

All of the porosity was not more than 1%.

Next, the thin film with thickness 0.25 μm which comprises as the main ingredients at least one or more materials selected from a gallium nitride, an indium nitride, and an aluminum nitride was directly formed on the substrate by using the same MOCVD equipment as what was used in Example 1 and 2.

The single crystal thin film of a 100% aluminum nitride was formed with thickness of 6 μm.

Thus, the half width of the rocking curve of the X ray diffraction of the Miller Index (002) lattice plane of the obtained single crystal thin film was measured.

As a result, in all the single crystal thin films, the half width of the rocking curve of the X ray diffraction of a Miller Index (002) lattice plane was not more than 300 seconds.

### EXAMPLE 6

The substrate which consists of a sintered compact which comprises an aluminum nitride as the main ingredients by using the same raw material as Example 2 was newly produced, then the characteristic of a substrate were investigated like Example 2, further, the single crystal thin film which comprises as the main ingredients at least one or more materials selected from a gallium nitride, an indium nitride, and an aluminum nitride was formed on these substrates like Example 1 and Example 2, the crystallinity was investigated.

When producing the sintered compact which comprises an aluminum nitride as the main ingredients, forming of a powder compact and degreasing of a powder compact were performed by the same method as Example 2.

What had nothing additives, such as sintering aids, was used as a powder compact, and MgO, CaCO₃, Al₂O₃, Y₂O₃, Er₂O₃, V₂O₅, and Cr₂O₃ were used as additives, such as sintering aids.

The details were indicated in Table 6.

After degreasing the above-mentioned powder compact containing the various additives, this powder compact was fired as a fired thing.

The firing of this powder compact was performed, by surrounding the circumferences by the frame of tungsten using the setter made from tungsten, after putting prepared another powder compact which consisted only of aluminum nitride powder in this setter with the fired thing, or by surrounding the circumference of a fired thing by the frame made from an aluminum nitride using the setter made from an aluminum nitride.

In performing hot press, firing under pressure was performed using what was once made into the sintered compact after normal pressure sintering of the powder compact was once carried out at 1820 degrees C. for 1 hour in nitrogen.

The result is shown in Table 6.

Consequently, the optical transmissivity of all the obtained sintered compacts which comprises an aluminum nitride as the main ingredients was not less than 30%.

Improving was confirmed if it is compared with the optical transmissivity of what does not contain the additive produced in Example 2, and of the sintered compact which comprises an aluminum nitride as the main ingredients and contains MgO, CaCO₃, Al₂O₃, Y₂O₃, and Er₂O₃ as additive.

In this Example, if it is compared with the Example 2 it seems that optical permeability improved more since the aluminum nitride ingredient was supplied into the firing atmosphere from other than the fired thing.

Although not indicated in Table 6, all the optical transmissivity of the sintered compact which comprises an aluminum nitride as the main ingredients and was obtained by carrying out the hot press of the powder compact which contains MgO, V₂O₅, and Cr₂O₃ as an additive by pressure 300 Kg/cm² at 1820 degrees C. in nitrogen atmosphere as it is for 1 hour, without once firing was 0%.

Thus, among the obtained various sintered compacts which comprise an aluminum nitride as the main ingredients, if the sintered compact which has the optical transmissivity not less than 40% and comprises an aluminum nitride as the main ingredients is used for a substrate, as for the crystallinity of the single crystal thin film which was directly formed on it and comprises as the main ingredients at least one or more materials selected from a gallium nitride, an indium nitride, and an aluminum nitride, it is shown that the half width of the rocking curve of the X ray diffraction line from the lattice plane of a Miller Index (002) is not more than 150 seconds.

In the sintered compact whose optical transmissivity is not less than 60%, the half width of the rocking curve of the X ray diffraction line from the lattice plane (002) of this single crystal thin film is not more than 130 seconds.

Moreover, even if it is the substrate which consists of an aluminum nitride sintered compact whose optical transmissivity in visible light is zero, as for the crystallinity of the single crystal thin film which was formed directly on it and comprises as the main ingredients at least one or more materials selected from a gallium nitride, an indium nitride, and an aluminum nitride, it is shown that the half width of the rocking curve of the X ray diffraction line from the lattice plane of a Miller Index (002) is not more than 200 seconds.

### EXAMPLE 7

The optical transmissivity of the sintered compact which was produced in Example 2 and 6 and which comprises an aluminum nitride as the main ingredients, was measured by using the light with 300 nm wavelength.

Except that light was replaced with ultraviolet rays, measurement was performed by the same method as Example 2.

The result is shown in Table 7.

In this result, as for the substrate which consists of a sintered compact which has high optical transmissivity of visible light and comprises an aluminum nitride as the main ingredients, it is shown that the transmissivity of ultraviolet rays also has a clearly high tendency.

As the optical transmissivity of 300 nm ultraviolet rays what is as high as a maximum of 67% is obtained.

### EXAMPLE 8

The sintered compact which was produced in Example 1-6 and comprises an aluminum nitride as the main ingredients, and the sintered compact which was produced in Example 1 and comprises as the main ingredients various ceramic materials of a silicon carbide, a silicon nitride, an aluminum oxide, a zinc oxide, and a beryllium oxide, were prepared.

The relation between the surface smooth nature of these substrates and the crystallinity of the single crystal thin film which was formed directly on it and comprises as the main ingredients at least one or more materials selected from a gallium nitride, an indium nitride, and an aluminum nitride was investigated.

As the surface smooth nature of a substrate, what is the following three kinds of states was used.

That is, 1) that whose substrate surface is in a as-fired state (as-fire) (however, a surface adhesion objects were removed with a brush using alumina powder), 2) what is in the state where grinding processing of the substrate surface was carried out by lap polish using SiC or an alumina grain, 3) what is in the state where the substrate surface was processed in the state of a mirror surface using the abradant which comprises as the main ingredients an alumina, a cerium oxide, a diamond, a silicon oxide, or a chromic oxide.

As for the grain used for lap polish and its particle size, in the case of the sintered compact which comprises an aluminum nitride as the main ingredients, what was produced and used in experiment No.1-5 of Example 1, and what was produced in experiment No.62 and 64 of Example 2 were used #240 of SiC, what was produced in experiment No.107 of Example 6 is used #280 of SiC, what was produced in experiment No.34 and 46 of Example 2, what was produced and used in experiment No.86-92 of Example 4, what was produced and used in experiment No.100-102 of Example 4, and what was produced in experiment No.105 of Example 6, were used #400 of SiC, in the case of other sintered compacts #600 of SiC was used.

In the case of the sintered compact which comprises a silicon carbide as the main ingredients, the grain of particle size #240 of SiC was used.

In the case of the sintered compact which comprises a silicon nitride as the main ingredients, the grain of particle size #800 of SiC was used.

In the case of the sintered compact which comprises a zinc oxide as the main ingredients, the grain of particle size #400 of alumina was used.

As for the sintered compact which comprises an aluminum nitride as the main ingredients and the sintered compact which comprises a silicon nitride as the main ingredients, lap polish was performed after grinding processing heat-treatment was performed at 1200 degrees C. in N₂ for 1 hour.

As for the sintered compact which comprises a silicon carbide as the main ingredients and which performed lap polish, heat-treatment was performed at 1200 degrees C. in argon for 1 hour after grinding processing.

As for the sintered compact which comprises a zinc oxide as the main ingredients and which performed lap polish, heat-treatment was performed at 1000 degrees C. in air for 1 hour after grinding processing.

The above-mentioned mirror surface processing was performed using the pad made from cloth of commercial item as polisher, using the followings as abradant, respectively.

That is, the abradant which comprises as the main ingredients the chromic oxide with 0.1 μm and 0.2-μm of particle diameter was used for mirror polishing of the substrate which consists of a sintered compact which comprises an aluminum nitride as the main ingredients.

The abradant which comprises as the main ingredients the diamond with 0.1 μm of particle diameter (specular surface 1) and the abradant which comprises as the main ingredients colloidal alumina of particle diameter of 0.05 μm (specular surface 2) were used for specular surface polish of the substrate which consists of a sintered compact which comprises a silicon carbide as the main ingredients, the abradant which comprises as the main ingredients the diamond with 0.25 μm of particle diameter (specular surface 3) and the abradant which comprises as the main ingredients colloidal alumina of particle diameter of 0.05 μm (specular surface 4) were used for specular surface polish of the substrate which consists of a sintered compact which comprises a silicon nitride as the main ingredients, the abradant which comprises as the main ingredients the diamond with 0.1 μm of particle diameter (specular surface 5) and the abradant which comprises as the main ingredients colloidal silicon oxide of particle diameter of 0.02 μm (specular surface 6) were used for specular surface polish of the substrate which consists of a sintered compact which comprises an aluminum oxide as the main ingredients, the abradant which comprises as the main ingredients the cerium oxide with 0.5 μm of particle diameter (specular surface 7) was used for specular surface polish of the substrate which consists of a sintered compact which comprises a zinc oxide as the main ingredients, the abradant which comprises as the main ingredients the diamond with 0.25 μm of particle diameter (specular surface 8) and the abradant which comprises as the main ingredients colloidal alumina of particle diameter of 0.05 μm (specular surface 9) were used for specular surface polish of the substrate which consists of a sintered compact which comprises a beryllium oxide as the main ingredients.

Although not indicated in Table 8, in the abradant which comprises as the main ingredients the chromic oxide used for specular surface polish of the substrate which consists of a sintered compact which comprises an aluminum nitride as the main ingredients, in the case of the substrate by using what is 0.1 μm of particle diameter, altogether what have the surface smooth nature not more than 100 nm as surface roughness Ra were obtained (the substrates used in experiment No.198-200 and experiment No.210-211).

All other substrates performed specular surface polish by the abradant which comprises as the main ingredients chromic oxide with 0.2 μm of particle diameter.

The surface smooth nature (shown as the surface roughness Ra) of each above-mentioned substrate and a surface state of a substrate which were produced like that were shown in Table 8.

After ultrasonic washing by acetone and IPA in each substrate which has the above surface states, the thin film which comprises as the main ingredients at least one or more materials selected from a gallium nitride, an indium nitride, and an aluminum nitride was formed like the Example 1 and the Example 2 by the thickness shown in Table 8, and the crystallinity was investigated.

The above experimental result is shown in Table 8.

Consequently, in the substrate using the sintered compact which comprises an aluminum nitride as the main ingredients, even if it is in the as-fired state (as-fire), on the surface, directly the thin film which comprises as the main ingredients at least one or more materials selected from a gallium nitride, an indium nitride, and an aluminum nitride can be formed in the state of single crystal, without becoming the polycrystalline state.

Surface smooth nature of a substrate of the substrate using the sintered compact which comprises an aluminum nitride as the main ingredients and is in the as-fired state (as-fire) is in the range of 90-1000 nm as average surface roughness Ra.

Even if what is in the state where lap polish of the surface was carried out in the substrate using the sintered compact which comprises an aluminum nitride as the main ingredients, on the surface, directly the thin film which comprises as the main ingredients at least one or more materials selected from a gallium nitride, an indium nitride, and an aluminum nitride can be formed in the state of single crystal, without becoming the polycrystalline state.

As for the surface smooth nature of the substrate using the sintered compact which comprises an aluminum nitride as the main ingredients in the state where lap polish of the surface was carried out, it is in the range of 100-2000 nm as average surface roughness Ra.

If what is in the state where mirror polishing of the surface was carried out in the substrate using the sintered compact which comprises an aluminum nitride as the main ingredients, on the surface, directly the thin film which comprises as the main ingredients at least one or more materials selected from a gallium nitride, an indium nitride, and an aluminum nitride can be formed in the state of single crystal, without becoming the polycrystalline state.

The surface smooth nature of the substrate using the sintered compact which comprises an aluminum nitride as the main ingredients and is in the state where the specular surface polishing was carried out is in the range of not more than 100 nm as average surface roughness Ra.

The result of this Example is shown in Table 8.

Namely, in the substrate using the sintered compact which comprises an aluminum nitride as the main ingredients, by using that whose surface state of the substrate carried out specular surface polish in the three above-mentioned kinds, as for the single crystal thin film which comprises as the main ingredients at least one or more materials selected from a gallium nitride, an indium nitride, and an aluminum nitride and is formed directly on the substrate, it was shown that what is more excellent crystallinity is easy to be obtained.

In Table 8, it is shown that the single-crystal-ized thin film which comprises as the main ingredients at least one or more materials selected from a gallium nitride, an indium nitride, and an aluminum nitride can be formed directly on the thing whose average surface roughness Ra of the substrate using the sintered compact which comprises an aluminum nitride as the main ingredients is not more than 2000 nm, and the single crystal thin film in which the half width of the rocking curve of the X ray diffraction line from the lattice plane of the Miller Index (002) of this single crystal thin film is not more than 3600 seconds is obtained.

It is shown that the single-crystal-ized thin film which comprises as the main ingredients at least one or more materials selected from a gallium nitride, an indium nitride, and an aluminum nitride can be formed directly on the thing whose average surface roughness Ra is not more than 1000 nm among the substrates using the sintered compact which comprises an aluminum nitride as the main ingredients, and the single crystal thin film in which the half width of the rocking curve of the X ray diffraction line from the lattice plane of the Miller Index (002) of this single crystal thin film is not more than not more than 1000 seconds is obtained.

It is shown that the single-crystal-ized thin film which comprises as the main ingredients at least one or more materials selected from a gallium nitride, an indium nitride, and an aluminum nitride can be formed directly on the thing whose average surface roughness Ra is not more than 100 nm among the substrates using the sintered compact which comprises an aluminum nitride as the main ingredients, and the single crystal thin film in which the half width of the rocking curve of the X ray diffraction line from the lattice plane of the Miller Index (002) of this single crystal thin film is not more than 300 seconds is obtained.

It is shown that the single-crystal-ized thin film which comprises as the main ingredients at least one or more materials selected from a gallium nitride, an indium nitride, and an aluminum nitride can be formed directly on the thing whose average surface roughness Ra is not more than 60 nm among the substrates using the sintered compact which comprises an aluminum nitride as the main ingredients, and the single crystal thin film in which the half width of the rocking curve of the X ray diffraction line from the lattice plane of the Miller Index (002) of this single crystal thin film is not more than 240 seconds is obtained.

It is shown that the single-crystal-ized thin film which comprises as the main ingredients at least one or more materials selected from a gallium nitride, an indium nitride, and an aluminum nitride can be formed directly on the thing whose average surface roughness Ra is not more than 30 nm among the substrates using the sintered compact which comprises an aluminum nitride as the main ingredients, and the single crystal thin film in which the half width of the rocking curve of the X ray diffraction line from the lattice plane of the Miller Index (002) of this single crystal thin film is not more than 200 seconds is obtained.

It is shown that the single-crystal-ized thin film which comprises as the main ingredients at least one or more materials selected from a gallium nitride, an indium nitride, and an aluminum nitride can be formed directly on the thing whose average surface roughness Ra is not more than 20 nm among the substrates using the sintered compact which comprises an aluminum nitride as the main ingredients, and the single crystal thin film in which the half width of the rocking curve of the X ray diffraction line from the lattice plane of the Miller Index (002) of this single crystal thin film is not more than 150 seconds is obtained.

In Table 8, in the substrate using the sintered compact which comprises an aluminum nitride as the main ingredients, it was shown that by using what carried out specular surface polish in the above-mentioned three kinds of as-fired state (as-fire), lap polish, and specular surface polish as the surface state of a substrate, as for the single crystal thin film which was formed directly on a substrate and comprises as the main ingredients at least one or more materials selected from a gallium nitride, an indium nitride, and an aluminum nitride, what was more excellent crystallinity was easy to be obtained.

If the substrate which has the surface state of as-fired state is compared with the substrate which has the surface state which carried out lap polish, it was shown that what is excellent crystallinity is easy to be obtained by using the substrate which has the surface state of as-fired state as the above-mentioned single crystal which was directly formed on it.

In the substrate using various sintered compacts which comprise as the main ingredients a ceramic material other than an aluminum nitride, even if it is in the as-fired state, on the surface, directly the thin film which comprises as the main ingredients at least one or more materials selected from a gallium nitride, an indium nitride, and an aluminum nitride can be formed in the state of single crystal, without becoming the polycrystalline state.

The surface smooth nature of the substrate using the sintered compact which comprises as the main ingredients various ceramics other than the aluminum nitride and is in the as-fired state is in the range of 90-1000 nm as average surface roughness Ra.

Even if what is in the state where lap polish of the surface was carried out in the substrate using the sintered compact which comprises as the main ingredients various ceramics other than an aluminum nitride, on the surface, directly the thin film which comprises as the main ingredients at least one or more materials selected from a gallium nitride, an indium nitride, and an aluminum nitride can be formed in the state of single crystal, without becoming the polycrystalline state.

The surface smooth nature of the substrate using the sintered compact which comprises as the main ingredients various ceramics other than an aluminum nitride in the state where lap polish of the surface was carried out is in the range of 80-1000 nm as average surface roughness Ra.

If what is in the state where mirror polishing of the surface was carried out in the substrate using the sintered compact which comprises as the main ingredients various ceramics other than an aluminum nitride, on the surface, directly the thin film which comprises as the main ingredients at least one or more materials selected from a gallium nitride, an indium nitride, and an aluminum nitride can be formed in the state of single crystal, without becoming the polycrystalline state.

The surface smooth nature of the substrate using the sintered compact which comprises as the main ingredients various ceramics other than an aluminum nitride in the state where mirror polishing of the surface was carried out is in the range of 1-100 nm as average surface roughness Ra.

In Table 8, it is shown that the single-crystal-ized thin film which comprises as the main ingredients at least one or more materials selected from a gallium nitride, an indium nitride, and an aluminum nitride can be formed directly on the thing whose average surface roughness Ra of the substrate using the sintered compact which comprises an aluminum nitride as the main ingredients is not more than 1000 nm, and the single crystal thin film in which the half width of the rocking curve of the X ray diffraction line from the lattice plane of the Miller Index (002) of this single crystal thin film is not more than 3600 seconds is obtained.

It is shown that the single-crystal-ized thin film which comprises as the main ingredients at least one or more materials selected from a gallium nitride, an indium nitride, and an aluminum nitride can be formed directly on the thing whose average surface roughness Ra is not more than 100 nm among the substrates using the sintered compact which comprises as the main ingredients various ceramics other than an aluminum nitridet, and the single crystal thin film in which the half width of the rocking curve of the X ray diffraction line from the lattice plane of the Miller Index (002) of this single crystal thin film is not more than 1000 seconds is obtained.

It is shown that the single-crystal-ized thin film which comprises as the main ingredients at least one or more materials selected from a gallium nitride, an indium nitride, and an aluminum nitride can be formed directly on the thing whose average surface roughness Ra is not more than 10 nm among the substrates using the sintered compact which comprises as the main ingredients various ceramics other than an aluminum nitridet, and the single crystal thin film in which the half width of the rocking curve of the X ray diffraction line from the lattice plane of the Miller Index (002) of this single crystal thin film is not more than 300 seconds is obtained.

It is shown that the single-crystal-ized thin film which comprises as the main ingredients at least one or more materials selected from a gallium nitride, an indium nitride, and an aluminum nitride can be formed directly on the thing whose average surface roughness Ra is not more than 5 nm among the substrates using the sintered compact which comprises as the main ingredients various ceramics other than an aluminum nitridet, and the single crystal thin film in which the half width of the rocking curve of the X ray diffraction line from the lattice plane of the Miller Index (002) of this single crystal thin film is not more than 240 seconds is obtained.

### EXAMPLE 9

The sintered compact which was produced in Example 1-6 and comprises an aluminum nitride as the main ingredients, and the sintered compact which was produced in Example 1 and comprises as the main ingredients various ceramic materials of a silicon carbide, a silicon nitride, an aluminum oxide, a zinc oxide, and a beryllium oxide, were prepared.

When forming the single crystal thin film which comprises as the main ingredients at least one or more materials selected from a gallium nitride, an indium nitride, and an aluminum nitride directly on these substrates by the same method as Example 1 and Example 2, the relation between the thickness after this single crystal thin film formation and the crystallinity of this formed single crystal thin film was investigated.

Mirror polishing of the surface of the used substrate made from a sintered compact which comprises an aluminum nitride and various ceramic materials as the main ingredients has been beforehand carried out by the same method as Example 8, and the surface roghness is shown in Table 9.

The substrate which consists of a sintered compact which comprises a zinc oxide as the main ingredients and was used in this Example is what was ground using the abradant which comprises as the main ingredients cerium oxide of 0.2 μm of particle diameter.

In this Example, the conditions of the thin film formation by the MOCVD method shown in Example 1 were changed, that is, the thin film formation was performed as substrate temperature at 1050 degrees C. in the case of a gallium nitride (GaN) thin film, at 650 degrees C. in the case of an indium nitride (InN) thin film, at 1200 degrees C. in the case of an aluminum nitride (AlN) thin film, and at 1100 degrees C. in the case of the mixed crystal thin film of 50 mol % GaN+50 mol % AlN.

The formation rate of a thin film is about 0.5-1.5μm/hour, about 0.5-1.5μm/hour, about 2-6 μm/hour, and about 1-3μm/hour, respectively.

Production of the single crystal thin film which comprises as the main ingredients a gallium nitride, an indium nitride, and an aluminum nitride was also performed newly by the Chloride VPE (Chloride Vapor Phase Epitaxy) method for having used a gallium chloride, an indium chloride, and an aluminium chloride for raw materials.

Nitrogen was used as career gas of the vaporized raw materials, and ammonia was used for reactive gas.

Rapid thin film formation was possible, such as 5 μm-200 μm per hour as thin film formation rate.

The single crystal thin film by this Chloride VPE method was formed on the substrate which was used in experiment No.193, 195, 197, 200, 202, 203, 209, 210, 211, 213, 215, 217, and 222.

As substrate temperature at the time of the single crystal thin film formation by the Chloride VPE method, it was carried out at 1150 degrees C. in the case of a gallium nitride thin film, at 800 degrees C. in the case of an indium nitride thin film, and at 1280 degrees C. in the case of an aluminum nitride thin film.

A carbon setter is heated by high frequency induction from the exterior, using a silica tube as a reaction chamber, then the indirect heating of the substrate placed on it which consists of a sintered compact which comprises an aluminum nitride and various ceramic materials as the main ingredients was performed.

The result is shown in Table 9.

In the result of Table 9, as for the crystallinity of the single crystal thin film which comprises as the main ingredients at least one or more materials selected from a gallium nitride, an indium nitride, and an aluminum nitride and was directly formed on the substrate according to this invention which consists of a sintered compact which comprises an aluminum nitride as the main ingredients, it is shown clearly that the half width of the rocking curve of the X ray diffraction line from the lattice plane of the Miller Index (002) of this single crystal thin film which comprises as the main ingredients at least one or more materials selected from a gallium nitride, an indium nitride, and an aluminum nitride is not more than 240 seconds, if the thickness of this single crystal thin film is not less than 0.3 μm.

And, as for the crystallinity of the single crystal thin film which comprises as the main ingredients at least one or more materials selected from a gallium nitride, an indium nitride, and an aluminum nitride and was formed directly on the substrate which consists of a sintered compact which comprises an aluminum nitride as the main ingredients, it is shown that the half width of the rocking curve of the X ray diffraction line from the lattice plane of the Miller Index (002) of this single crystal thin film which comprises as the main ingredients at least one or more materials selected from a gallium nitride, an indium nitride, and an aluminum nitride is not more than 200 seconds, if the thickness of this single crystal thin film is not less than 3.5 μm.

And, as for the crystallinity of the single crystal thin film which comprises as the main ingredients at least one or more materials selected from a gallium nitride, an indium nitride, and an aluminum nitride and was formed directly on the substrate which consists of a sintered compact which comprises an aluminum nitride as the main ingredients, it is shown that the half width of the rocking curve of the X ray diffraction line from the lattice plane of the Miller Index (002) of this single crystal thin film which comprises as the main ingredients at least one or more materials selected from a gallium nitride, an indium nitride, and an aluminum nitride is not more than 150 seconds, if the thickness of this single crystal thin film is not less than 10 μm.

Moreover, as for the crystallinity of the single crystal thin film which comprises as the main ingredients at least one or more materials selected from a gallium nitride, an indium nitride, and an aluminum nitride and was formed directly on the substrate which consists of a sintered compact which comprises an aluminum nitride as the main ingredients, it is shown that the half width of the rocking curve of the X ray diffraction line from the lattice plane of the Miller Index (002) of this single crystal thin film which comprises as the main ingredients at least one or more materials selected from a gallium nitride, an indium nitride, and an aluminum nitride is not more than 130 seconds, if the thickness of this single crystal thin film is not less than 50 μm.

Moreover, in the above-mentioned single crystal thin film forming method, it was also shown that the thick single crystal film up to about 500 μm-1000 μm which is excellent in crystallinity can be formed using the Chloride VPE method.

On the other hand, in the case of the substrate using the sintered compact which consists of ceramic material which comprises as the main ingredients a silicon carbide, a silicon nitride, a zinc oxide, a beryllium oxide, and an aluminum oxide other than an aluminum nitride, it was shown that even if the thickness of the single crystal thin film which comprises as the main ingredients at least one or more materials selected from a gallium nitride, an indium nitride, and an aluminum nitride and was formed directly on it was at least not less than 0.3 μm, the crystallinity of this single crystal thin film was good.

That is, it is shown that the half width of the rocking curve of the X ray diffraction line from the lattice plane of the Miller Index (002) of a single crystal thin film with the thickness not less than 0.3 μm which comprises as the main ingredients at least one or more materials selected from a gallium nitride, an indium nitride, and an aluminum nitride and which was formed directly on the above-mentioned substrate using the sintered compact which consists of a ceramic material which comprises as the main ingredients a silicon carbide, a silicon nitride, a zinc oxide, a beryllium oxide, and an aluminum oxide other than the aluminum nitride is not more than 300 seconds. And, it is shown that the half width of the rocking curve of the X ray diffraction line from the lattice plane of the Miller Index (002) of a single crystal thin film with the thickness not less than 3.5 μm is not more than 240 seconds.

Moreover, it is shown that the half width of the rocking curve of the X ray diffraction line from the lattice plane of the Miller Index (002) of a single crystal thin film with the thickness not less than 10 μm is also not more than 240 seconds.

Observation of obtained thin films was performed using the optical microscope and the electron microscope, consequently, a crack is not seen in the inside of thin films which were produced by the MOCVD method and the Chloride VPE method, and exfoliation was not seen at a junction interface between the thin films and the sintered compact which comprises an aluminum nitride as the main ingredients and the other various sintered compacts which comprise a ceramic material as the main ingredients.

Tested by pasting up and tearing off after adhesive tape is pasted up to each thin film obtained, consequently, there is nothing that exfoliates in an interface between the thin films and the sintered compact which comprises an aluminum nitride as the main ingredients and the other various sintered compacts which comprise a ceramic material as the main ingredients do not have, the sintered compact which comprises an aluminum nitride as the main ingredients and the other various sintered compacts which comprise a ceramic material as the main ingredients are joined with a thin film firmly.

The thin film conductivity material of Ti/Pt/Au was formed on each formed above-mentioned thin film, the metal lead was soldered and perpendicular tensile strength was investigated, consequently, it all is not less than 2 Kg/mm², so the sintered compact which comprises an aluminum nitride as the main ingredients and the other various sintered compacts which comprise a ceramic material as the main ingredients are joined with each above-mentioned thin film firmly.

And, specular surface polish was further carried out by the abradant which comprises as the main ingredients colloidal silicon oxide of particle diameter of 0.02 μm after polishing of the thin films which were produced in experiment No.191 192, 193, 206, 208, and 220 by using the abradant which comprises as the main ingredients chromic oxide of 0.2 μm of particle diameter, the surface roughness (Ra) was 1.2 nm (experiment No.191), 1.04 nm (experiment No.192), 0.94 nm (experiment No.193), 1.1 nm (experiment No.206), 1.06 nm (experiment No.208), and 0.99 nm (experiment No.220), respectively, all are not more than 2 nm, it was confirmed that the single crystal thin film substrate which is excellent in smooth nature was obtained.

### EXAMPLE 10

The sintered compact which was produced in Example 1-6 and comprises an aluminum nitride as the main ingredients, and the sintered compact which was produced in Example 1 and comprises as the main ingredients various ceramic materials, such as a silicon carbide, a silicon nitride, an aluminum oxide, a zinc oxide, and a beryllium oxide, were prepared.

Mirror surface polishing is given to these substrate surfaces by the same method as Example 8 and Example 9.

Two or more layers of the single crystal thin films which comprise as the main ingredients at least one or more materials selected from a gallium nitride, an indium nitride, and an aluminum nitride was formed on the above-mentioned sintered compact substrates by the MOCVD method and the Chloride VPE method on the same conditions as what was shown in Example 1, Example 2, or Example 9 except having changed substrate temperature, then the crystallinity of each single crystal thin film layer obtained was investigated.

The Chloride VPE method was used only when forming the thin film exceeding the thickness of 15 μm.

The thin film was formed using Dimethyl beryllium, Bis-cyclopentadienyl magnesium, diethyl zinc, and SiH₄ as raw material for doping in the case of thin film formation by the MOCVD method, and by using MgBr₂ as raw material for doping in the case of the thin film formation by the Chloride VPE method.

When a thin film was formed using the MOCVD method, 1st layer of the thin film which was directly formed on the sintered compact which comprises an aluminum nitride as the main ingredients was fomed by the same raw material, gas, substrate temperature, and other formation conditions as Example 1.

As for the 2nd layer and the 3rd layer of the thin films which were formed on the 1st layer, the formation was performed at 950 degrees C. as substrate temperature in the case of what comprises GaN as the main ingredients, at 750 degrees C. as substrate temperature in the case of what comprises InN as the main ingredients, at 1050 degrees C. as substrate temperature in the case of what comprises AlN as the main ingredients, in addition, the used raw material, gas, and the conditions of thin film formation were same as the Example 1, irrespective of the existence of doping ingredient content. The substrate temperature was 1000 degrees C. in the case of what comprises a mixed crystal of GaN+AlN as the main ingredients, irrespective of the existence of doping ingredient content, the substrate temperature was 800 degrees C. in the case of the mixed crystal of GaN+InN, in addition, raw materials, gas, and the conditions of thin film formation were same as the Example 1.

In the thin film formation by a Chloride VPE method, formation of the thin film which contains Mg as a doping ingredient in mixed crystal which comprises GaN+AlN as the main ingredients was performed at 1200 degrees C. as the substrate temperature, in addition it was carried out by same materials, gas, formation conditions, etc. as the Example 9.

The constitution of the single crystal thin film layer which was formed in two or more layers as mentioned above is the following three kinds.

That is, 1) what formed the single crystal thin film of the same composition separately in 2 steps or more, 2) the thing whose composition of a gallium nitride, an indium nitride, and an aluminum nitride which are the main ingredients differs, 3) the thing whose main ingredients are the same but whose content of the ingredient of very small quantity, such as a doping agent, differ.

After the above-mentioned thin film formation by the MOCVD method and an Chloride VPE method, the substrate which formed the thin film which has the doping ingredient of Be, Mg, Zn, and Si other than the ingredient which comprises as the main ingredients at least one or more materials selected from a gallium nitride, an indium nitride, and an aluminum nitride, was heat-treated at 700 degrees C. in pure N₂ atmosphere.

Thus, the crystallinity of each single crystal thin film layer obtained was investigated.

In the single crystal thin film of the constitution of two or more layers, the crystallinity of the single crystal thin film which was formed below the surface layer was investigated by X ray diffraction before the upside single crystal thin film layer is formed, or it investigated, after carrying out grinding removal of the upside single crystal thin film layer.

The result is shown in Table 10.

In the column of thin film composition of Table 10, what is the 1st layer is a single crystal thin film currently directly formed on the sintered compact substrate,what is the 2nd layer is the single crystal thin film directly formed on the single crystal thin film of the 1st layer, and what is the 3rd layer is the single crystal thin film directly formed on the single crystal thin film of the 2nd layer.

So that clearly from Table 10, if the substrate according to this invention which consists of a sintered compact which comprises an aluminum nitride and various ceramic materials as the main ingredients is used, as for the crystallinity of single crystal thin films which were formed on these substrates in two or more layers and comprise as the main ingredients at least one or more materials selected from a gallium nitride, an indium nitride, and an aluminum nitride, it is shown that what are not more than 300 seconds altogether as half width of the rocking curve of the X ray diffraction line from the lattice plane of a Miller Index (002) are obtained.

As shown in Table 10, it was also confirmed that the crystallinity of each single crystal thin film layer (the 2nd layer and 3rd layer) which was formed on the above-mentioned substrate which consists of a sintered compact which comprises an aluminum nitride and various ceramic materials as the main ingredients in the constitution of two or more layers has the tendency which was more excellent if it is compared with the crystallinity of the single crystal thin film of the 1st layer.

And, when using the sintered compact which comprises an aluminum nitride as the main ingredients in the above-mentioned substrates, as for the crystallinity of each single crystal thin film layer (the 2nd layer and 3rd layer) which was formed on this substrate in the constitution of two or more layers, the half width of the rocking curve of the X ray diffraction line from the lattice plane of a Miller Index (002) is not more than 150 seconds, it was shown that what is further excellent is obtained if it is compared with the various sintered compacts which comprise as the main ingredients a ceramic material which has the crystal structure which can be classified as a hexagonal system, such as a silicon carbide, a silicon nitride, a zinc oxide, and a beryllium oxide etc., and classified as a trigonal system or a hexagonal system, such as an aluminum oxide etc.

The electric resistivity was measured in room temperature about each single crystal thin film of the 2nd layer which doped Si in experiment No.237 and 238, consequently, that is 0.6 Ω·cm (49.94 mol % GaN+49.94 mol % AlN+0.12 mol % Si) and 86 Ω·cm (99.94 mol % AlN+0.06 mol % Si), respectively, it was confirmed that they have semiconductor-ized.

The electric resistivity was measured in room temperature about each single crystal thin film which doped Mg, Be, and Zn of the 3rd layer in experiment No.240, the 2nd layer in experiment No.241, and the 2nd layer in experiment No.242, consequently, that is 0.097 Ω·cm (99.9 mol % GaN+0.1 mol % Mg), 0.44 Ω·cm (99.9 mol % GaN+0.1 mol % Be), and 0.26 Ω·cm (99.9 mol % GaN+0.1 mol % Zn), it was confirmed that they have semiconductor-ized,respectively.

Moreover, the electric resistivity was measured in room temperature about each single crystal thin film of the 2nd layer in experiment No.239, the 3rd layer in experiment No.241, and the 4th layer in experiment No.246, consequently, they were 0.054 Ω·cm (100% GaN), 0.036 Ω·cm (70 mol % GaN+30 mol % InN), and 0.011 Ω·cm (100% InN), respectively, GaN, InN, and GaN+InN which do not contain a doping element have semiconductor-ized spontaneously.

As mentioned above, in this invention, as for the thin film substrate on which the single crystal thin film of at least one layer and two layers which comprises as the main ingredients at least one or more materials selected from a gallium nitride, an indium nitride, and an aluminum nitride was formed on the sintered compact which comprises an aluminum nitride as the main ingredients or the various sintered compacts which comprise as the main ingredients a ceramic material, such as a silicon carbide, a silicon nitride, an aluminum oxide, a zinc oxide, and a beryllium oxide, it was shown that the single crystal thin film which comprises as the main ingredients at least one or more materials selected from a gallium nitride, an indium nitride, and an aluminum nitride can be formed furthermore on it.

As for the crystallinity of the single crystal thin film formed on the single crystal thin film of at least one layer and two layers which comprises as the main ingredients at least one or more materials selected from a gallium nitride, an indium nitride, and an aluminum nitride and was formed beforehand on the above-mentioned substrate which consists of various sintered compacts which comprise a ceramic material as the main ingredients, it was confirmed that it is easy to improve than the single crystal thin film which is under it.

Thus, as for the above-mentioned thin film substrate on which the single crystal thin film of at least one layer and two layers which comprises as the main ingredients at least one or more materials selected from a gallium nitride, an indium nitride, and an aluminum nitride was formed on the sintered compact which comprises an aluminum nitride as the main ingredients or the various sintered compacts which comprise as the main ingredients a ceramic material, such as a silicon carbide, a silicon nitride, an aluminum oxide, a zinc oxide, and a beryllium oxide, it was confirmed that it can be used also as a substrate for forming a single crystal thin film which comprises as the main ingredients at least one or more materials selected from a gallium nitride, an indium nitride, and an aluminum nitride.

### EXAMPLE 11

The high purity aluminum nitride powder [grade “H” by Tokuyama Soda Co., Ltd. (present: Tokuyama, Inc.)] manufactured by the method of reduction of an oxide (aluminum oxide) and “TOYALNITE” by Toyo Aluminium K.K. produced by the method of direct nitriding of metal aluminum were prepared as a raw material powder for sintered compact production which comprises an aluminum nitride as the main ingredients, and various rare earth element compounds and alkaline-earth-metals compound powder were prepared as sintering aids.

As a result of analysis, oxygen is contained 1.2 weight % in “H” grade, oxygen is contained 1.4 weight % in “TOYALNITE” as impurities.

Mean particle sizes of powders are 0.9 μm and 1.1 μm, respectively.

In addition to this, an aluminum oxide, carbon, silicon, etc. were prepared as an additive.

The powder compact of various compositions was produced by the same method as Example 2 using these raw materials.

So that sintering aids etc. might not vaporize as much as possible using a part of powder compact which was obtained in this way, it fired at 1800 degrees C. by the same method as Example 2 for 1 hour, so the beforehand fired sintered compact was also produced.

The sample of experiment No.283-286 of Table 11 and Table 12 in which the contents of this Example is shown is it as the beforehand fired sintered compact.

After putting the powder compact and the beforehand fired sintered compact which were obtained as mentioned above on the setter made from carbon they were put into the saggar made from carbon, they were fired at high temperature and for long time in nitrogen atmosphere containing carbon monoxide 1000 ppm by using a carbon furnace, and the sintered compact which comprises an aluminum nitride as the main ingredients was obtained.

As for the obtained sintered compacts, the chemical composition analysis, the fixed quantity of the AlN crystal phase by X ray diffraction, and size measurement of an aluminum nitride particle were performed.

The fixed quantity of the AlN crystal phase by X ray diffraction is the value calculated by deducting the quantity of this crystal phases other than AlN from the quantity of the whole crystal phase, after the diffraction peak of crystal phases other than AlN was measured and the percentage ratio between it and the strongest diffraction peak of AlN was asked for.

Next, specular polish of the surface of the obtained sintered compact was carried out into 30 nm, and the optical transmissivity to the light with a wavelength 605 nm was measured by the same method as Example 2.

The measured optical transmissivity is total transmissivity.

Furthermore, by using the substrate in which a specular surface polish was carried out, the single crystal thin film which comprises as the main ingredients at least one or more materials selected from a gallium nitride, an indium nitride, and an aluminum nitride by the same method as Example 1 and Example 2 was formed, and the crystallinity of this single crystal thin film was investigated.

These results are shown in Table 11 and Table 12.

Table 11 describes about the composition of the powder compact for sintered compact production which comprises an aluminum nitride as the main ingredients, firing conditions, and composition and the characteristic of the obtained sintered compact.

In Table 12, when the obtained sintered compact which comprises an aluminum nitride as the main ingredients is used for as a substrate, composition of the single crystal thin film formed in these substrates and its crystallinity are shown.

That is, the sintered compact which comprises an aluminum nitride as the main ingredients and which raised AlN purity by the above-mentioned method was obtained.

In the powder compact which contains simultaneously a rare earth element compound and an alkaline-earth-metals compound which were used as sintering aids or in a beforehand fired sintered compact, since ingredients, such as sintering aids, are vaporized and removed in lower temperature and in short time, there is a tendency in which the purity of AlN of this sintered compact which comprises an aluminum nitride as the main ingredients tends to increase.

The single crystal thin film which comprises as the main ingredients at least one or more materials selected from a gallium nitride, an indium nitride, and an aluminum nitride was formed using this sintered compact as a substrate, and the crystallinity of this single crystal thin film was investigated.

Consequently, the sintered compact which comprises an aluminum nitride as the main ingredients and consists of the composition wherein the content of at least one or more compounds selected from a rare earth element compound and an alkaline-earth-metals compound is a total of not more than 0.5 weight % by element conversion and the content of oxygen is not more than 0.9 weight % can be obtained.

As for the single crystal thin film which comprises as the main ingredients at least one or more materials selected from a gallium nitride, an indium nitride, and an aluminum nitride and is directly formed on the substrate of this composition, what has good crystallinity of at least not more than 240 seconds as half width of the rocking curve of the X ray diffraction line from the lattice plane of a Miller Index (002) is obtained.

And, the sintered compact which comprises an aluminum nitride as the main ingredients and consists of the composition whose content of at least one or more compounds selected from a rare earth element compound and an alkaline-earth-metals compound is a total of not more than 0.2 weight % by element conversion and whose content of oxygen is not more than 0.5 weight % can be obtained.

As for the single crystal thin film which comprises as the main ingredients at least one or more materials selected from a gallium nitride, an indium nitride, and an aluminum nitride and is directly formed on the substrate of this composition, what has good crystallinity of at least not more than 200 seconds as half width of the rocking curve of the X ray diffraction line from the lattice plane of a Miller Index (002) is obtained.

And, the sintered compact which comprises an aluminum nitride as the main ingredients and consists of the composition whose content of at least one or more compounds selected from a rare earth element compound and an alkaline-earth-metals compound is a total of not more than 0.05 weight % by element conversion and whose content of oxygen is not more than 0.2 weight % can be obtained.

As for the single crystal thin film which comprises as the main ingredients at least one or more materials selected from a gallium nitride, an indium nitride, and an aluminum nitride and is directly formed on the substrate of this composition, what has good crystallinity not more than 150 seconds as half width of the rocking curve of the X ray diffraction line from the lattice plane of a Miller Index (002) is obtained.

And, the sintered compact which comprises an aluminum nitride as the main ingredients and consists of the composition whose content of at least one or more compounds selected from a rare earth element compound and an alkaline-earth-metals compound is a total of not more than 0.02 weight % by element conversion and whose content of oxygen is not more than 0.1 weight % can be obtained.

As for the single crystal thin film which comprises as the main ingredients at least one or more materials selected from a gallium nitride, an indium nitride, and an aluminum nitride and is directly formed on the substrate of this composition, what has good crystallinity not more than 130 seconds as half width of the rocking curve of the X ray diffraction line from the lattice plane of a Miller Index (002) is obtained.

Moreover, the sintered compact which comprises an aluminum nitride as the main ingredients and consists of the composition whose content of at least one or more compounds selected from a rare earth element compound and an alkaline-earth-metals compound is a total of not more than 0.005 weight % by element conversion and whose content of oxygen is not more than 0.05 weight % can be obtained.

As for the single crystal thin film which comprises as the main ingredients at least one or more materials selected from a gallium nitride, an indium nitride, and an aluminum nitride and is directly formed on the substrate of this composition, what has good crystallinity not more than 100 seconds as half width of the rocking curve of the X ray diffraction line from the lattice plane of a Miller Index (002) is obtained.

In the sintered compact which comprises an aluminum nitride as the main ingredients and which raised the AlN purity obtained in this Example, the size of an aluminum nitride particle increased by raising firing temperature or lengthening firing time.

That is, the single crystal thin film which comprises as the main ingredients at least one or more materials selected from a gallium nitride, an indium nitride, and an aluminum nitride was formed by using as a substrate the above-mentioned sintered compact which comprises an aluminum nitride as the main ingredients and raised the AlN purity, in which the size of an aluminum nitride particle increased, then the crystallinity of this single crystal thin film was investigated.

Consequently, that whose AlN purity is high and whose size of an aluminum nitride particle in a sintered compact is an average of not less than 5 μm is obtained.

In the substrate whose size of an aluminum nitride particle in a sintered compact is an average of not less than 5 μm, good thing whose half width of the rocking curve of the X ray diffraction line from the lattice plane of the Miller Index (002) of the single crystal thin film which comprises as the main ingredients at least one or more materials selected from a gallium nitride, an indium nitride, and an aluminum nitride and is directly formed on this substrate is not more than 200 seconds was obtained.

And, that whose AlN purity is high and whose size of an aluminum nitride particle in a sintered compact is an average of not less than 8 μm is obtained.

In the substrate whose size of an aluminum nitride particle in a sintered compact is an average of not less than 8 am, good thing whose half width of the rocking curve of the X ray diffraction line from the lattice plane of the Miller Index (002) of the single crystal thin film which comprises as the main ingredients at least one or more materials selected from a gallium nitride, an indium nitride, and an aluminum nitride and is directly formed on this substrate is not more than 150 seconds was obtained.

And, that whose AlN purity is high and whose size of an aluminum nitride particle in a sintered compact is an average of not less than 15 μm is obtained.

In the substrate whose size of an aluminum nitride particle in a sintered compact is an average of not less than 15 μm, good thing whose half width of the rocking curve of the X ray diffraction line from the lattice plane of the Miller Index (002) of the single crystal thin film which comprises as the main ingredients at least one or more materials selected from a gallium nitride, an indium nitride, and an aluminum nitride and is directly formed on this substrate is not more than 130 seconds was obtained.

Moreover, that whose AlN purity is high and whose size of an aluminum nitride particle in a sintered compact is an average of not less than 25 μm is obtained.

In the substrate whose size of an aluminum nitride particle in a sintered compact is an average of not less than 25 μm, still good thing whose half width of the rocking curve of the X ray diffraction line from the lattice plane of the Miller Index (002) of the single crystal thin film which comprises as the main ingredients at least one or more materials selected from a gallium nitride, an indium nitride, and an aluminum nitride and is directly formed on this substrate is not more than 100 seconds was obtained.

In the sintered compact obtained in this Example which comprises an aluminum nitride as the main ingredients and raised the AlN purity, the transmissivity in the light of the range of 200 nm-800 nm wavelength of the sintered compact which comprises an aluminum nitride as the main ingredients by raising firing temperature, or by lengthening firing time increased.

That is, the single crystal thin film which comprises as the main ingredients at least one or more materials selected from a gallium nitride, an indium nitride, and an aluminum nitride, was formed by using as a substrate the above-mentioned sintered compact which comprises an aluminum nitride as the main ingredients and raised the AlN purity and whose optical transmissivity increased, then the crystallinity of this single crystal thin film was investigated.

Consequently, as for the crystallinity of the single crystal thin film which was directly formed on this substrate and which comprises as the main ingredients at least one or more materials selected from a gallium nitride, an indium nitride, and an aluminum nitride, good thing whose half width of the rocking curve of the X ray diffraction line from the lattice plane of the Miller Index (002) is not more than 150 seconds was obtained by using as a obtained substrate the sintered compact which comprises an aluminum nitride as the main ingredients and which has high AlN purity and has the optical transmissivity not less than 40% in the light of the range of 200 nm-800 nm wavelength.

Moreover, as for the crystallinity of the single crystal thin film which comprises as the main ingredients at least one or more materials selected from a gallium nitride, an indium nitride, and an aluminum nitride, good thing whose half width of the rocking curve of the X ray diffraction line from the lattice plane of the Miller Index (002) is not more than 130 seconds was obtained by using as a substrate the sintered compact which comprises an aluminum nitride as the main ingredients and has not less than 60% of high optical transmissivity of visible light.

Moreover, as for the crystallinity of the single crystal thin film which comprises as the main ingredients at least one or more materials selected from a gallium nitride, an indium nitride, and an aluminum nitride, good thing whose half width of the rocking curve of the X ray diffraction line from the lattice plane of the Miller Index (002) is not more than 100 seconds was obtained by using as a substrate the sintered compact which comprises an aluminum nitride as the main ingredients and has not less than 80% of high optical transmissivity of visible light.

As for the sintered compact which comprises an aluminum nitride as the main ingredients and which was obtained except in experiment No.252-255 and 272, 273, 275, and 276, it had high characteristic whose thermal conductivity is not less than 200 W/mK in room temperature.

Moreover, as for what contains AlN not less than 99% as a crystal phase and as for the sintered compact which comprises an aluminum nitride as the main ingredients and is AlN single phase, what has still higher characteristic whose thermal conductivity is not less than 220 W/mK in room temperature and is a maximum of 237 W/mK was obtained.

So that clearly from Table 11 and 12, the origin of raw material powder is influenced not much, even if it uses any one among a powder compact and a beforehand fired sintered compact, if it fires at high temperature for a long time, phenomenon, such as vaporization and removal of sintering aids, oxygen, etc., arises, the sintered compact which comprises an aluminum nitride as the main ingredients will progress into high purity state.

Furthermore, the aluminum nitride particle in a sintered compact also grows, the transmissivity of sintered compact oneself and others improves, what is the transmissivity not less than 80% in the light of the range of the 200 nm-800 nm wavelength, and a maximum of 88% are obtained.

And, the crystallinity of the single crystal thin film which comprises as the main ingredients at least one or more materials selected from a gallium nitride, an indium nitride, and an aluminum nitride and which is formed on the obtained substrate which consists of a sintered compact which comprises an aluminum nitride as the main ingredients, also improves.

As for the crystallinity of this single crystal thin film, if the composition, i.e., the AlN purity, of the obtained sintered compact which comprises an aluminum nitride as the main ingredients, becomes high, crystallinity will increase.

As for the crystallinity of this single crystal thin film, there was a tendency where not only the above-mentioned AlN purity but also in addition to it the influence which the size of an aluminum nitride particle or optical transmissivity has influences more greatly.

That is, if the size of an aluminum nitride particle becomes large, the crystallinity of this single crystal thin film will increase further.

If the optical transmissivity of the substrate which consists of a sintered compact which comprises an aluminum nitride as the main ingredients becomes high, the crystallinity of this single crystal thin film will increase further like increasing of the size of the above-mentioned aluminum nitride particle.

That is, as for the crystallinity of this single crystal thin film obtained in this Example, it seems that these elements, i.e., ;the AlN purity which is a composition of a sintered compact which comprises an aluminum nitride as the main ingredients and which is used as a substrate becomes high, the size of an aluminum nitride particle increases, and the optical transmissivity of the sintered compact which comprises an aluminum nitride as the main ingredients becomes high;, will raise the crystallinity of the single crystal thin film which comprises as the main ingredients at least one or more materials selected from a gallium nitride, an indium nitride, and an aluminum nitride by a synergistic effect of each other.

That is, it is effective to use the sintered compact which comprises an aluminum nitride as the main ingredients and whose inside of a sintered compact was reformed by the high temperature and prolonged firing as the above-mentioned substrate for thin film formation in order to obtain the single crystal thin film with high crystallinity.

### COMPARATIVE EXAMPLE

In order to compare, the same powder compact as experiment No.265 is put on the setter made from tungsten, it put into the saggar made from tungsten with the aluminum nitride powder prepared independently, then it was fired at the temperature of 2200 degrees C. for 8 hours in pure nitrogen atmosphere by the tungsten furnace which consists of tungsten furnace material and a heating element, consequently, most yttrium oxide which is a sintering aid is not vaporized and removed but it remained in the state of the powder compact, high purity is not attained.

Thermal conductivity is also as low as not more than 200 W/mK, optical permeability is also 62%, they were smaller than what was produced in experiment No.265 of Table 11.

### EXAMPLE 12

Using as a substrate the sintered compacts which were produced and used in Example 1—the Example 11, such as the sintered compact which comprises an aluminum nitride as the main ingredients, and the various sintered compacts which comprise as the main ingredients a ceramic material, such as a silicon carbide, a silicon nitride, an aluminum oxide, a zinc oxide, and a beryllium oxide, formation of an amorphous thin film, a polycrystalline thin film, and an orientated polycrystalline thin film which comprise as the main ingredients at least one or more materials selected from a gallium nitride, an indium nitride, and an aluminum nitride was tried by the MOCVD method.

In the MOCVD method in this Example, the same raw material and same equipment as Example 1, Example 2, and Example 10 are used.

Mirror polishing of the surface of the above-mentioned substrate is carried out by the same method as Example 8 and Example 9, and the surface smooth nature is shown in Table 13.

Furthermore, formation of the single crystal thin film which comprises as the main ingredients at least one or more materials selected from a gallium nitride, an indium nitride, and an aluminum nitride on the substrate in which this amorphous thin film, the polycrystalline thin film, and the orientated polycrystalline thin film, etc. were formed was tried.

First, thin film formation was tried, that is, the substrate temperature was 300 degrees C.-700 degrees C. in the case of the thin film which comprises a gallium nitride (GaN) as the main ingredients, the substrate temperature was 300 degrees C.-600 degrees C. in the case of the thin film which comprises an indium nitride (InN) as the main ingredients, and the substrate temperature was 350 degrees C.-1000 degrees C. in the case of the thin film which comprises an aluminum nitride (AlN) as the main ingredients.

The 100 mol % GaN thin film shown in experiment No.287 and 293 of Table 13 is produced with the substrate temperature of 340 degrees C.

The 100 mol % AlN thin film shown in experiment No.288, 289, 290, 292, 294, 297, 298, 299, 300, and 301 is produced with the substrate temperature of 370 degrees C.

The 100 mol % AlN thin film shown in experiment No.296 is produced with the substrate temperature of 400 degrees C.

The 100 mol % AlN thin film shown in experiment No.295 is produced with the substrate temperature of 1050 degrees C.

Thus, the crystallized state of the obtained above-mentioned thin film (thin film by the side of a substrate) which comprises as the main ingredients at least one or more materials selected from a gallium nitride, an indium nitride, and an aluminum nitride and which was formed directly on the substrate which consists of a sintered compact which comprises an aluminum nitride as the main ingredients and various sintered compacts which comprise a ceramic material as the main ingredients was investigated by X ray diffraction.

About the thin film which comprises an aluminum nitride as the main ingredients, electron beam diffraction was also used together for the judgment of a crystallized state.

Consequently, the crystallized state of the obtained thin film was clearly what shows an amorphous state, or a polycrystal, or an orientated polycrystal.

The result is shown in Table 13.

In this Example, the AlN thin film of the polycrystalline state directly formed on the substrate used in experiment No.291 was an orientated polycrystal currently formed in the direction where C axis is perpendicular to the substrate surface.

The half width of the rocking curve of the X ray diffraction line from the lattice plane of the Miller Index (002) of this orientated polycrystalline thin film measured was 4620 seconds.

Formation of the AlN orientated polycrystalline thin film formed directly on the substrate of above-mentioned experiment No.291 which consists of a sintered compact which comprises an aluminum nitride as the main ingredients was performed with the substrate temperature of 550 degrees C.

In only the experiment No.295 of Table 13, formation of an AlN single crystal thin film was tried as a thin film directly formed on a substrate.

In experiment No.295, substrate temperature was set up at 1100 degrees C. higher than the above-mentioned conditions, thin film formation was performed by the MOCVD method whose other raw material, the gas, and the formation conditions are same as Example 1.

Thus, the obtained 100 mol % AlN thin film of experiment No.295 shown in Table 13 is a single crystal currently formed in the direction where C axis is perpendicular to the substrate surface, and the half width of the rocking curve of the X ray diffraction line from the lattice plane of the Miller Index (002) of this single crystal thin film measured was 127 seconds.

Thus, in this Example, it was shown clearly that the thin film substrate which formed not only the single crystal but the thin film which comprises as the main ingredients at least one or more materials selected from a gallium nitride, an indium nitride, and an aluminum nitride and which is various crystallized states, such as an amorphous state, a polycrystal, and an orientated polycrystal etc., directly onto the above-mentioned sintered compact which comprises an aluminum nitride as the main ingredients and the various sintered compacts which comprise a ceramic material as the main ingredients can be obtained.

Next, in experiment No.293, and 299 and 301, the substrate in which one layer of thin films which comprise as the main ingredients the gallium nitride and aluminum nitride containing the doping ingredient of very small quantity was formed furthermore on the thin film substrate which consists of a sintered compact which comprises an aluminum nitride as the main ingredients, and a sintered compact which comprises an aluminum oxide and a beryllium oxide as the main ingredients, on which the amorphous thin film which comprises a gallium nitride and an aluminum nitride as the main ingredients was formed beforehand directly was produced under substrate temperature of 450 degrees C. (experiment No.293) and 550 degrees C. (experiment No. 299 and 301) respectively.

Other formation conditions are the same as that of the MOCVD method shown in Example 1 and Example 10.

The obtained thin film was the orientated polycrystal of which C axis was clearly formed perpendicularly to the substrate surface as a result of X ray diffraction.

As half width of the rocking curve of the X ray diffraction line from the lattice plane of the Miller Index (002) of these orientated polycrystals, it was 4540 seconds in the case of experiment No.293, 10820 seconds in the case of experiment No.299, and 9890 seconds in the case of experiment No.301

Thus, in the case of the orientated polycrystal which was formed by using the substrate which consists of a sintered compact which comprises an aluminum nitride as the main ingredients, the tendency whose thing excellent in crystallinity is obtained was shown if it is compared with what used the substrate which consists of a sintered compact which comprises an aluminum oxide and a beryllium oxide as the main ingredients.

It explained above, in this Example, it was shown clearly that a thin film substrate which formed at least one layer or two layers of thin films which comprise as the main ingredients at least one or more materials selected from a gallium nitride, an indium nitride, and an aluminum nitride and which are various crystallized states, such as an amorphous state, a polycrystal, and an orientated polycrystal etc., onto the sintered compact which comprises an aluminum nitride as the main ingredients and the various sintered compacts which comprise a ceramic material as the main ingredients can be obtained.

Next, formation of the single crystal thin film which comprises as the main ingredients at least one or more materials selected from a gallium nitride, an indium nitride, and an aluminum nitride was tried by the MOCVD method on such thin film substrates which consist of a sintered compact comprising an aluminum nitride as the main ingredients and various sintered compacts comprising a ceramic material as the main ingredients and which formed one layer and two layers of thin films of various crystallized states, such as an amorphous thin film, a polycrystalline thin film, and an orientated polycrystalline thin film etc.

The substrate in which the 100 mol % AlN single crystal thin film produced by experiment No.295 was formed was also used for the trial of this single crystal thin film formation.

As for what comprises GaN, InN, and AlN as the main ingredients on the occasion of formation of a single crystal thin film, the used raw material, gas, formation conditions, etc. were same as Example 1 and Example 10, irrespective of the existence of doping ingredient content.

On the other hand, substrate temperature was 1050 degrees C. in the case of what comprises a mixed crystal of GaN+AlN as the main ingredients, irrespective of the existence of doping ingredient content, substrate temperature was 830 degrees C. in the case of what comprises a mixed crystal of GaN+InN as the main ingredients, in addition, raw materials, gas, and the formation conditions were same as Example 1, Example 2, and Example 10.

Thus, the substrate in which one layer of thin films which comprise as the main ingredients at least one or more materials selected from a gallium nitride, an indium nitride, and an aluminum nitride were formed furthermore on the substrate on which the thin films of various crystallized states, such as an amorphous thin film, a polycrystalline thin film, and an orientated polycrystalline thin film, etc., were formed was obtained.

Thus, when X ray diffraction analyzed the formed thin film, it was confirmed that all are a single crystal.

These single crystal thin film is formed in the direction where C axis is perpendicular to the substrate surface.

It investigated about the crystallinity of the obtained single crystal thin film, and the result was shown in Table 13.

About the thin film which comprises an aluminum nitride as the main ingredients, electron beam diffraction was also used together for the judgment of a crystallized state.

As a result, it became clear that the substrate in which the thin film of the two-layer constitution in which at least the surface one consists of a single crystal thin film was formed is obtained.

Moreover, in experiment No.293, 299 and 301, it became clear that the substrate in which the thin film of the three-layer constitution in which the surface one consists of a single crystal thin film was formed is obtained.

As mentioned above, the substrates of experiment No.291 and 292 were selected from the substrate which has thin film of a two-layer constitution and formed a single crystal thin film in the layer of the surface side, then formation of a single crystal thin film was tried using the MOCVD method of the same conditions as the above.

As a result, the thin film newly formed at the surface side was clearly a single crystal which is formed in the direction where C axis is perpendicular to the substrate surface, by X ray diffraction.

As this result, in experiment No. 291 and 292, it was confirmed that the substrate which consists of a constitution of three layers of thin films which have two layers of single crystal thin films is producible.

In experiment No. 291 and 292, the crystallinity of the single crystal thin film formed in the last at the surface side is improving than the crystallinity of the single crystal thin film formed first (and which is formed as the intermediate layer).

That is, in experiment No.291, while the half width of the rocking curve of the X ray diffraction line from the lattice plane of the Miller Index (002) of the single crystal thin film formed first is 96 seconds, it was 91 seconds in the case of the single crystal thin film formed on it.

And, in experiment No.292, while the half width of the rocking curve of the X ray diffraction line from the lattice plane of the Miller Index (002) of the single crystal thin film formed first is 97 seconds, it was 89 seconds in the case of the single crystal thin film formed on it.

So that clearly from Table 13, the single crystal thin film which comprises as the main ingredients at least one or more materials selected from a gallium nitride, an indium nitride, and an aluminum nitride can be formed on the substrate which consists of a sintered compact which comprises an aluminum nitride as the main ingredients and which formed beforehand at least one layer or two layers of thin films of various crystallized states, such as an amorphous thin film, a polycrystalline thin film, and an orientated polycrystalline thin film.

As fot the crystallinity, the half width of the rocking curve of the X ray diffraction line from the lattice plane of the Miller Index (002) of the single crystal thin film which comprises as the main ingredients at least one or more materials selected from a gallium nitride, an indium nitride, and an aluminum nitride was not more than 100 seconds in all the tested substrates.

Usually, when the single crystal thin film which comprises as the main ingredients at least one or more materials selected from a gallium nitride, an indium nitride, and an aluminum nitride was formed directly on the sintered compact which comprises an aluminum nitride as the main ingredients and which was used in this Example and was produced in experiment No. 46, 49, 110, 267, and 283, though these single crystal thin films which have high crystallinity, such that the half width of the rocking curve of the X ray diffraction line from the lattice plane of the Miller Index (002) becomes not more than 100 seconds, are hard to obtain, if the substrate which consists of a sintered compact which comprises an aluminum nitride as the main ingredients and which formed beforehand at least one layer or two layers of thin films of various crystallized states, such as an amorphous thin film, a polycrystalline thin film, and an orientated polycrystalline thin film is used as mentioned above, it was confirmed that there is the tendency in which the crystallinity of the single crystal thin film which is formed improves further than the case where a single crystal thin film is formed directly on the substrate which consists of a sintered compact which comprises an aluminum nitride as the main ingredients.

And, the single crystal thin film which comprises as the main ingredients at least one or more materials selected from a gallium nitride, an indium nitride, and an aluminum nitride can also be formed on the substrate which consists of a sintered compact which comprises as the main ingredients the ceramic material which has the crystal structure which can be classified as a hexagonal system or a trigonal system such as a silicon carbide, a silicon nitride, a zinc oxide, a beryllium oxide, and an aluminum oxide, etc. on which at least one layer or two layers of thin films of various crystallized states, such as an amorphous thin film, a polycrystalline thin film, and an orientated polycrystalline thin film are formed beforehand.

As fot the crystallinity, the half width of the rocking curve of the X ray diffraction line from the lattice plane of the Miller Index (002) of the single crystal thin film which comprises as the main ingredients at least one or more materials selected from a gallium nitride, an indium nitride, and an aluminum nitride was not more than 200 seconds in all the tested substrates.

Usually, when the single crystal thin film which comprises as the main ingredients at least one or more materials selected from a gallium nitride, an indium nitride, and an aluminum nitride was formed directly on the sintered compact which comprises as the main ingredients the ceramic material which has the crystal structure which can be classified as a hexagonal system or a trigonal system, such as a silicon carbide, a silicon nitride, a zinc oxide, a beryllium oxide, and an aluminum oxide etc., and which was produced in Example 1 and was used in this Example, though these single crystal thin films which have high crystallinity, such that the half width of the rocking curve of the X ray diffraction line from the lattice plane of the Miller Index (002) becomes not more than 200 seconds, are hard to obtain, if the substrate which consists of a sintered compact which comprises as the main ingredients the ceramic material which has the crystal structure which can be classified as a hexagonal system or a trigonal system such as a silicon carbide, a silicon nitride, a zinc oxide, a beryllium oxide, and an aluminum oxide, etc. on which at least one layer or two layers of thin films of various crystallized states, such as an amorphous thin film, a polycrystalline thin film, and an orientated polycrystalline thin film are formed beforehand as mentioned above is used, it was confirmed that there is the tendency in which the crystallinity of the single crystal thin film which is formed improves further than the case where a single crystal thin film is formed directly on the substrate which consists of a sintered compact which comprises as the main ingredients the ceramic material which has the crystal structure which can be classified as a hexagonal system or a trigonal system such as a silicon carbide, a silicon nitride, a zinc oxide, a beryllium oxide, and an aluminum oxide, etc.

Thus, if at least one layer or two layers of thin films of various crystallized states, such as an amorphous thin film, a polycrystalline thin film, and an orientated polycrystalline thin film are formed beforehand, it was confirmed that the single crystal thin film of comparatively high crystallinity which comprises as the main ingredients at least one or more materials selected from a gallium nitride, an indium nitride, and an aluminum nitride is formed easily on the substrate which consists of a sintered compact which comprises as the main ingredients the ceramic material which has the crystal structure which can be classified as a hexagonal system or a trigonal system such as a silicon carbide, a silicon nitride, a zinc oxide, a beryllium oxide, and an aluminum oxide, etc.

So that clearly from having explained above, in this Example, the thin film substrate in which the thin film which comprises as the main ingredients at least one or more materials selected from a gallium nitride, an indium nitride, and an aluminum nitride and has various crystallized states, such as a single crystal, an amorphous state, a polycrystal, and an orientated polycrystal etc., was formed in two layers and three layers can be obtained easily.

It was confirmed that the single crystal thin film which has the excellent crystallinity can be formed in the layer of at least the most surface side among the thin films formed in these two layers and three layers.

As for this single crystal thin film, it was confirmed experimentally what has high crystallinity is obtained than what was formed directly on the substrate which consists of a sintered compact which comprises an aluminum nitride as the main ingredients and a sintered compact which comprises as the main ingredients the ceramic material which has the crystal structure which can be classified as a hexagonal system or a trigonal system such as a silicon carbide, a silicon nitride, a zinc oxide, a beryllium oxide, and an aluminum oxide, etc

In this Example, as for the substrate which consists of a sintered compact which comprises an aluminum nitride as the main ingredients and which was used in experiment No.294, though the single crystal thin film which comprises as the main ingredients at least one or more materials selected from a gallium nitride, an indium nitride, and an aluminum nitride and which is formed directly on this substrate has originally good crystallinity, such that the half width of the rocking curve of the X ray diffraction line from the lattice plane of a Miller Index (002) is 92 seconds as shown in Example 11, if the substrate in which the amorphous thin film was formed beforehand on the substrate which consists of a sintered compact which comprises an aluminum nitride as the main ingredients is used, the crystallinity of the single crystal thin film formed on it increases further into 82 seconds.

As for what used the substrate of experiment No.295, including the thin film which was formed directly on the substrate at first, all layers are single crystals.

Although the half width of the rocking curve of the X ray diffraction line from the lattice plane of the Miller Index (002) of the single crystal thin film formed directly at first was 127 seconds, the half width of the rocking curve of the X ray diffraction line from the lattice plane of the Miller Index (002) of the single crystal thin film formed on it was 87 seconds, the crystallinity has been improved further.

As mentioned above, in this Example, as for the thin film substrate in which at least 1-2 layers of thin films which comprise as the main ingredients at least one or more materials selected from a gallium nitride, an indium nitride, and an aluminum nitride were formed on the sintered compact which comprises an aluminum nitride as the main ingredients or the various sintered compacts which comprise as the main ingredients a ceramic material, such as a silicon carbide, a silicon nitride, an aluminum oxide, a zinc oxide, and a beryllium oxide, it was shown that the thin film which comprises as the main ingredients at least one or more materials selected from a gallium nitride, an indium nitride, and an aluminum nitride can be formed on it.

That is, as for the above-mentioned thin film substrate in which at least 1-2 layers of thin films which comprise as the main ingredients at least one or more materials selected from a gallium nitride, an indium nitride, and an aluminum nitride and which have various crystallized states, such as a single crystal, an amorphous state, a polycrystal, and an orientated polycrystal etc., were formed on the sintered compact which comprises an aluminum nitride as the main ingredients or on the various sintered compacts which comprise as the main ingredients a ceramic material, such as a silicon carbide, a silicon nitride, an aluminum oxide, a zinc oxide, and a beryllium oxide, it was confirmed that it can use also as a substrate for forming a thin film which comprises as the main ingredients at least one or more materials selected from a gallium nitride, an indium nitride, and an aluminum nitride (namely, substrate for thin film formation).

### EXAMPLE 13

Using the powder compacts produced in Example 11, using the powder compact of experiment No.269 used in Example 11, using the same carbon setter, carbon saggar, and carbon furnace as Example 11, and replacing firing atmosphere with four kinds, such as nitrogen including carbon monoxide 150 ppm, nitrogen including hydrogen 60 ppm, nitrogen including hydrocarbon 240 ppm, and argon including carbon monoxide 1800 ppm, it was fired at the temperature of 2200 degrees C. for 4 hours, and the sintered compact which comprises an aluminum nitride as the main ingredients was obtained.

As a result, in what was fired in the above atmosphere of all, the content of yttrium and calcium has become not more than 0.5 ppm respectively like Example 11.

The aluminum nitride particle also grew up into 35 μm-40 μm, and all optical transmissivity also exceeded 80%.

Furthermore, a substrate was produced using the sintered compact which comprises an aluminum nitride as the main ingredients and was obtained in each atmosphere, a gallium nitride single crystal thin film was formed in the thickness of 0.5 μm by the MOCVD method like Example 1, consequently, the half width of the rocking curve of the X ray diffraction line from the lattice plane of the Miller Index (002) of this single crystal thin film was 100 seconds in all substrates, good crystallinity has been shown.

### EXAMPLE 14

High purity aluminum nitride powder [grade “H” by Tokuyama Soda Co., Ltd. (present: Tokuyama, Inc.)] was prepared as raw material powder for sintered compact production which comprises an aluminum nitride as the main ingredients.

This raw material powder is manufactured by method of oxide reduction.

What added only Y₂O₃ powder to this raw material powder 5 weight % and what added 5 weight % of Y₂O₃ powder and 0.5 weight % of CaCO₃ powder by CaO conversion were mixed with toluene and iso propyl alcohol by a ball mill for 24 hours, then 12 weight parts of an acrylics binder was added to 100 weight parts of the raw material powder, further it mixed for 12 hours and changed into a paste state, the green sheet which has two kinds of composition with a thickness of 0.8 mm by the doctor blade method was produced.

The sheets with square shape whose one-side is 35 mm were produced from this green sheet, and the circular through holes which have the diameter of 25 μm and 50 μm and which penetrate the surface and the back were formed by YAG laser on this sheet.

Next, alpha terpineol was used as a solvent, the acrylic resin was used as a binder, tungsten powder was used as a conductive ingredient, and further, the above-mentioned aluminum nitride powder was added to this tungsten powder in the range of 0-20 weight %, and mixed them, then the pastes for conduction vias were produced.

The powder paste of each mixture ratio was filled up in the above-mentioned through holes, then it dried, and after the binder was removed suitably in the atmosphere which comprises as the main ingredients nitrogen or mixed gas of nitrogen and hydrogen, the sintered compact which comprises an aluminum nitride as the main ingredients and which has a conduction via was produced on the following two firing conditions.

Firing conditions are two conditions, that is, 1) normal pressure sintering is carried out at 1800 degrees C. for 2 hours in N₂ atmosphere, 2) firing at 2200 degrees C. for 4 hours in nitrogen atmosphere including carbon monoxide 200 ppm.

Thus, the sintered compact which comprises an aluminum nitride as the main ingredients, in which the conduction via was formed in the inside was obtained.

In any sintered compact, the conductive ingredient in a through hole was made dense enough, and conductivity has been generated, it is also uniting with the sintered compact which comprises an aluminum nitride as the main ingredients, it is functioning as a conduction via.

In the case of the above-mentioned sintered compact which comprises an aluminum nitride as the main ingredients in which the conduction via was formed by normal pressure sintering at 1800 degrees C. for 2 hours, sintering aids hardly vaporized and optical transmissivity was in the range of 51% -65%, but in the case of what was fired at 2200 degrees C. for 4 hours, sintering aids vaporize and the content of yttrium and calcium has become a total of not more than 50 ppm. The aluminum nitride particle was also growing up into 35 μm-45 μm, and optical transmissivity was also not less than 80%.

The obtained sintered compact was ground and polished into the size of diameter 25.4 mm×thickness 0.5 mm, so a conduction via is exposed, thus the substrate of the surface roughness Ra=30 nm which consists of a sintered compact which comprises an aluminum nitride as the main ingredients and which has a conduction via was produced.

The resistance in the room temperature of a conduction via was measured by 4 terminal method after that, and the electric resistivity in room temperature was calculated from the shape of a conduction via.

The size of a conduction via has shrunk after firing and has become the diameter of 40-44 μm and 20-23 μm, respectively.

The single crystal thin film of a gallium nitride was formed directly on one surface of the above-mentioned substrate in which the conduction via was formed in the thickness of 0.25 μm by the method using the same MOCVD equipment as what was used in Example 1 and 2 on, and the half width of the rocking curve of the X ray diffraction line from the lattice plane of the Miller Index (002) of this single crystal thin film was measured.

Those results were shown in Table 14.

Observation was performed about the single crystal thin film of the circumference in which the conduction via is formed after single crystal thin film formation, consequently, especially faults, such as a crack and exfoliation in an interface with a conduction via, are not found, but are in a good appearance state, and it was confirmed that the conduction via which used the material according to this invention has good junction nature to a gallium nitride thin film.

Although the electric resistivity of a conduction via changed by the content of an aluminum nitride, the firing conditions and the diameter of a through hole, etc., it is the range of 6.8×10⁻⁶ Ω·cm-132×10⁻⁶ Ω·cm in room temperature, and all the half width of the rocking curve of the X ray diffraction line from the lattice plane of the Miller Index (002) of this single crystal thin film is not more than 300 seconds.

In the substrate obtained by firing at 1800 degrees C. for 2 hour, the tendency in which the crystallinity of this single crystal thin film formed in the substrate improves is seen as the content of the aluminum nitride in a conduction via increases, in the conduction via which contains aluminum nitride powder not less than 10 weight %, the half width of the rocking curve of the X ray diffraction line from the lattice plane of the Miller Index (002) of this single crystal thin film increased in not more than 150 seconds.

As for the half width of the rocking curve of the X ray diffraction line from the lattice plane of the Miller Index (002) of this single crystal thin film formed in the substrate which has the conduction via obtained by firing at 2200 degrees C. for 4 hours, what is high crystallinity not more than 100 seconds was obtained.

The electric resistivity of each thin film which was produced in this Example and comprises a gallium nitride as the main ingredients is the range of 0.059 Ω·cm-0.101 Ω·cm in room temperature, and it has conductivity.

An electrical connection is between the thin film which comprises as the main ingredients this gallium nitride produced using each sintered compact in which the conduction via is formed, and the conduction via exposed in the substrate surface side in which this thin film is not formed.

Thus, it was confirmed that there is not only mechanical junction nature but also the electrical connectivity between the single crystal thin film which comprises as the main ingredients the gallium nitride which has the conductivity which was created in this Example and a conduction via.

### EXAMPLE 15

The powder compact which has the shape of disk, the outer size of diameter 32 mm, and various thickness was produced by using the mixed powder which contains yttrium oxide 5 weight % as a sintering aid in aluminum nitride raw material powder by the method of oxide reduction used in Example 11.

This powder compact was fired at 2200 degrees C. for 8 hours in the nitrogen atmosphere which contains 1000 ppm carbon monoxide in a carbon furnace using the setter made from carbon, and the saggar made from carbon like Example 11.

Consequently, the sintered compact which has translucency was obtained when the thickness of a powder compact is not more than 8 mm.

If the thickness is beyond it, it has become black and there is no translucency, it was hard to form a single crystal thin film which comprises as the main ingredients at least one or more materials selected from a gallium nitride, an indium nitride, and an aluminum nitride, and became the thin film of the polycrystalline state which is not a single crystal according to the case.

### EXAMPLE 16

As for a conductive single crystal thin film which comprises as the main ingredients a gallium nitride and an aluminum nitride and which is expressed with the chemistry composition formula of AlₓGa₁₋ₓN (0≦x≦1.0) in which Mg and Si are doped up to 10 mol %, respectively, to the above-mentioned composition, and are doped up to a total of 10 mol % in case of the simultaneous doping of Mg and Si, production was tried by the MOCVD method, using as a substrate the sintered compact which comprises an aluminum nitride as the main ingredients and which was produced in Example 1-15 and was used.

As a substrate, the sintered compact of experiment No.49 produced in Example 2, the sintered compact of experiment No.73 produced in Example 3, the sintered compact of experiment No.75, the sintered compact of experiment No.80, the sintered compact of experiment No.82, the sintered compact of experiment No.110 produced in Example 6, the sintered compact of experiment No.284 produced in Example 11, the sintered compact of experiment No.305 produced in Example 14, the sintered compact of experiment No.311, and the sintered compact of experiment No.317, were used.

The conduction via was formed, respectively and this conduction via is exposed to the up-and-down surface of a substrate in the sintered compact of experiment No.73, the sintered compact of experiment No.75, the sintered compact of experiment No.80, the sintered compact of experiment No.82, the sintered compact of experiment No.305, the sintered compact of experiment No.311, and the sintered compact of experiment No.317.

The production conditions of a single crystal thin film are the same as Example 1, Example 2, and Example 10.

The shape of a substrate is the same as that of Example 1, 3, and 14.

Thickness of a thin film was set to 3 μm, and was formed in one surface side of the substrate produced using each sintered compact.

After thin film formation by CVD, the substrate in which the thin film was formed was heat-treated at 700 degrees C. in pure N₂ atmosphere.

Consequently, a single crystal thin film can be formed in all compositions of above-mentioned AlₓGa₁₋ₓN (0≦x≦1.0) which doped Mg and Si up to 10 mol % on the substrate using each sintered compact, such as experiment No.73, the sintered compact of experiment No.75, the sintered compact of experiment No.80, the sintered compact of experiment No.82, and the sintered compact of experiment No.305, the half width of the rocking curve of the X ray diffraction line from the lattice plane of a Miller Index (002) of this single crystal thin film was as good as not more than 200 seconds.

And, a single crystal thin film can be formed in all compositions of above-mentioned AlₓGa₁₋ₓN (0≦x≦1.0) which doped Mg and Si up to 10 mol % on the substrate using each sintered compact of experiment No.49 and experiment No.110, the half width of the rocking curve of the X ray diffraction line from the lattice plane of a Miller Index (002) of this single crystal thin film was as good as not more than 150 seconds.

And, a single crystal thin film can be formed in all compositions of above-mentioned A₁₋ₓGa₁₋ₓN (0≦x≦1.0) which doped Mg and Si up to 10 mol % on the substrate using each sintered compact of experiment No.284, experiment No.311, and experiment No.317, the half width of the rocking curve of the X ray diffraction line from the lattice plane of a Miller Index (002) of this single crystal thin film was still as better as not more than 100 seconds.

The circumference of a conduction via was observed, as for the single crystal thin film produced by using the sintered compact of experiment No.73, the sintered compact of experiment No.75, the sintered compact of experiment No.80, the sintered compact of experiment No.82, the sintered compact of experiment No.305, the sintered compact of experiment No.311, and the sintered compact of experiment No.317, where a conduction via is formed, consequently, especially faults, such as a crack and exfoliation in an interface with a conduction via, are not found, but are in a good appearance state, it was confirmed that the conduction via which used the material according to this invention has good junction nature between the single crystal thin films which have composition of AlₓGa₁₋ₓN (0≦x≦1.0) and the single crystal thin film which has the composition which doped Si and Mg to AlxGal, N (0≦x≦1.0).

The electric resistivity was measured in room temperature about the single crystal thin film of these various composition, consequently, in what contains Mg in the range of 0.00001-10 mol % to the composite expressed with the chemical formula of AlₓGa₁₋ₓN (0≦x≦1.0), electric resistivity in room temperature was not more than 1×10⁴ Ω·cm.

Among these, in the single crystal thin film which contains Mg in the range of 0.00001-10 mol % to the composite expressed with the chemical formula of AlₓGa₁₋ₓN (0≦x≦0.6).

Moreover, in the single crystal thin film which contains Si in the range of 0.00001-0.5 mol % to the composite expressed with the chemical formula of AlₓGa₁₋ₓN (0.6≦x≦1.0) showed the electric resistivity of the range of 1×10⁰ Ω·cm-1×10³ Ω·cm in room temperature.

In the single crystal thin film of this composition, the thin film in which x=1.0, that is, the main ingredient consists only of an aluminum nitride and Si is contained in the range of 0.00001 mol %-0.5-mol %, is included, the electric resistivity in room temperature was the range of 40 Ω·cm-200 Ω·cm.

And, as for the single crystal thin film which contains Mg and Si simultaneously in the range of 0.00001-10 mol % to the composite expressed with the chemical formula of AlₓGa₁₋ₓN (0.6≦x≦1.0), what is 1×10⁻¹ Ω·cm-1×10³ Ω·cm was obtained as electric resistivity in room temperature.

And, the single crystal thin film which contains Si in the range of 0.00001-10 mol % to the composite expressed with the chemical formula of AlₓGa₁₋ₓN (0≦x≦0.6) showed the comparatively low resistance of the range of 1×10⁻³ Ω·cm-1×10¹ Ω·cm as electric resistivity in room temperature.

Moreover, the single crystal thin film which contains Si and Mg simultaneously in the range of 0.00001-10 mol % to the composite expressed with the chemical formula of AlₓGa₁₋ₓN (0≦x≦0.6) showed the comparatively low resistance of the range of 1×10⁻³ Ω·cm-1×10¹ Ω·cm as electric resistivity in room temperature.

And, there is an electrical connection between the single crystal thin film produced by using the sintered compact of experiment No.73, the sintered compact of experiment No.75, the sintered compact of experiment No.80, the sintered compact of experiment No.82, the sintered compact of experiment No.305, the sintered compact of experiment No.311, and the sintered compact of experiment No.317, where a conduction via is formed, and the conduction via which has been exposed in the substrate surface in which this thin film is not formed, it was confirmed that there is not only mechanical junction nature but also the electrical connectivity between the single crystal thin film which has composition of AlₓGa₁₋ₓN (0≦x≦1.0) which has the conductivity created in this Example and a conduction via.

These results were described in Table 15.

In Table 15, in a thin film, the amount of doping agent addition has shown as mol % to main-ingredients AlₓGa₁₋ₓN.

That is, for example, that the amount of addition of Mg is 0.5-mol % means that the thin film formed has the composition whose AlₓGa₁₋ₓN of the main ingredient is 99.5 mol %, and whose Mg of the doping agent is 0.5 mol %.

### EXAMPLE 17

As for an electrical conductive single crystal thin film, an amorphous thin film, a polycrystalline thin film, and an orientated polycrystalline thin film with C axis perpendicular to a substrate surface, and they comprise as the main ingredients at least one or more materials selected from a gallium nitride, an indium nitride, and an aluminum nitride, formation was tried by the MOCVD method like Example 1, Example 2, Example 10, and Example 12, using as a substrate each sintered compact of experiment No.73, 75, 80, 82, 305, 311, and 317 which was used in Example 16 and comprises an aluminum nitride as the main ingredients and which has a conduction via, and the sintered compact of experiment No.49 which comprises an aluminum nitride as the main ingredients and which does not have a conduction via,

The thin film was formed in one side of each substrate as the single layer or two layers (the layer of surface coat and the layer of a substrate side).

On the occasion of formation of the indium nitride thin film of experiment No. 350 and 351, it carried out at each substrate temperature of 320 degrees C., and 360 degrees C.

In addition, on the occasion of formation of the gallium nitride thin film of experiment No. 347 and 356, it carried out at each substrate temperature of 340 degrees C., and 380 degrees C.

Thickness of each thin film layer was set to 3 μm, respectively.

Consequently, as for the thin film which comprises as the main ingredients at least one or more materials selected from a gallium nitride, an indium nitride, and an aluminum nitride, even if it is amorphouses, polycrystals, and orientated polycrystals other than a single crystal, it became clear that what has conductivity can be formed on the sintered compact which comprises an aluminum nitride as the main ingredients.

It became clear that the thin film which has conductivity can also be formed as the constitution of two or more layers.

The circumference of a conduction via was observed, as for the thin film of a single crystal, an amorphous state, and a polycrystal produced by using the sintered compact of experiment No.73, the sintered compact of experiment No.75, the sintered compact of experiment No.80, the sintered compact of experiment No.82, the sintered compact of experiment No.305, the sintered compact of experiment No.311, and the sintered compact of experiment No.317, where a conduction via is formed, consequently, especially faults, such as a crack and exfoliation in an interface with a conduction via, are not found, but are in a good appearance state, and it was confirmed that the conduction via which used the material according to this invention has good junction nature to the thin film of various compositions which comprises as the main ingredients at least one or more materials selected from a gallium nitride, an indium nitride, and an aluminum nitride. And, each thin film produced by using the sintered compact of experiment No.73, the sintered compact of experiment No.75, the sintered compact of experiment No.80, the sintered compact of experiment No.82, the sintered compact of experiment No.305, the sintered compact of experiment No.311, and the sintered compact of experiment No.317, where a conduction via is formed, has an electrical connection with the conduction via which have been exposed in the substrate surface in which this thin film is not formed, it was confirmed that there is not only mechanical junction nature but also the electrical connectivity between the conduction via and the electrical conductive single crystal thin film, amorphous thin film, polycrystalline thin film, and orientated polycrystalline thin film with C axis perpendicular to a substrate surface, which comprise as the main ingredients at least one or more materials selected from a gallium nitride, an indium nitride, and an aluminum nitride and consist of various compositions and which were created in this Example.

These results were described in Table 16.

### EXAMPLE 18

The substrate which consists of a sintered compact which comprises an aluminum nitride as the main ingredients in which various thin film conductivity material was formed was obtained by forming various material, such as titanium, chromium, nickel, molybdenum, tungsten, platinum, aluminum, tantalum, tantalum nitride, titanium nitride, gold, copper, tungsten/copper alloy (W: 70 weight % +Cu: 30 weight %), etc. on the both sides of a substrate by the RF Sputtering method of frequency 13.56 MHz and output 500 W-1500 W on the substrates which were used in Example 16 and Example 17 and which consist of a sintered compact which comprises an aluminum nitride as the main ingredients and which has a conduction via and a sintered compact which comprises an aluminum nitride as the main ingredients and which does not have a conduction via.

Substrate temperature is 250 degrees C., Sputtering was performed passing Ar+N₂ gas in a decompression chamber.

The reflectance of the produced thin film conductivity material to the light with a wavelength 605 nm was measured, and it was shown in Table 17.

The thin film which comprises as the main ingredients at least one or more materials selected from a gallium nitride, an indium nitride, and an aluminum nitride and added the doping agent suitably was formed in the thickness of 3 μm on one side of the substrate on which this various thin film conductivity material was formed.

Consequently, even if it is the substrates in which various thin film conductivity material was formed beforehand, it was confirmed that the thin film of an amorphous state, an orientated polycrystal, and a single crystal can form.

It was confirmed that the orientated polycrystalline thin film and the single crystal thin film are formed in the direction where C axis is perpendicular to a substrate surface, respectively.

The result investigated about the crystallinity of such thin film was shown in Table 17.

As for the crystallinity of a single crystal thin film, the half width of the rocking curve of the X ray diffraction line from the lattice plane of the Miller Index (002) of this single crystal thin film was not more than 200 seconds.

In the thin film which comprises as the main ingredients at least one or more materials selected from a gallium nitride, an indium nitride, and an aluminum nitride, shown in Table 17, what was measured as a single crystal was formed on the same conditions as Example 10, amorphous thin films and orientated polycrystalline thin films other than a single crystal are formed on the same conditions as what was indicated in Example 12.

And, although not indicated in Table 17, by using the substrate of experiment No.360, experiment No.362-364, experiment No.366-367, experiment No.369, and experiment No.372 in which thin film conductivity material was formed and the amorphous thin film and an orientated polycrystalline thin film were formed on it, on it, formation of the single crystal thin film of 100 mol % GaN and a 100 mol % AlN was tried by the same method as Example 1, the half width of the rocking curve of the X ray diffraction line from the lattice plane of the Miller Index (002) of this single crystal thin film of all was not more than 100 seconds.

As shown in Table 17, observation of appearance was performed about the formed thin film which comprises as the main ingredients at least one or more materials selected from a gallium nitride, an indium nitride, and an aluminum nitride, consequently, especially faults, such as a crack and exfoliation in an interface with thin film conductivity material, are not found, but are in a good appearance state, it was confirmed that the thin film conductivity material which used the material according to this invention has good junction nature to the thin film of various compositions which comprises as the main ingredients at least one or more materials selected from a gallium nitride, an indium nitride, and an aluminum nitride.

In order to confirm junction nature between the thin film conductivity material and the thin film of various compositions which comprises as the main ingredients at least one or more materials selected from a gallium nitride, an indium nitride, and an aluminum nitride, the next test was performed furthermore.

In the testing method, the circular aluminum pin with a diameter of 3 mm was pasted up on the produced substrate by epoxy resin, and perpendicular tensile strength was measured, all are not less than 2 Kg/mm as perpendicular tensile strength.

Exfoliation exists in an adhesion interface between epoxy resin and the thin film of various compositions which comprises as the main ingredients at least one or more materials selected from a gallium nitride, an indium nitride, and an aluminum nitride, or in the adhesion interface between the epoxy resin and the pin, or in the inside of an epoxy resin, it was confirmed that the exfoliation or destruction between the thin film conductivity material and the thin films of various compositions which comprises as the main ingredients at least one or more materials selected from a gallium nitride, an indium nitride, and an aluminum nitride are not seen, but good junction nature is formed.

Furthermore, although junction nature was tested by the method of pasting up pressure sensitive adhesive tape on the produced substrates, and tearing off the tape, the exfoliation or the destruction between the thin film conductivity material and the thin film of various compositions which comprises as the main ingredients at least one or more materials selected from a gallium nitride, an indium nitride, and an aluminum nitride were not seen altogether.

And, the electrical conductive thin film which comprises as the main ingredients at least one or more materials selected from a gallium nitride, an indium nitride, and an aluminum nitride which was produced by using the sintered compact of experiment No.73, the sintered compact of experiment No.75, the sintered compact of experiment No.80, the sintered compact of experiment No.82, the sintered compact of experiment No.305, the sintered compact of experiment No.311, and the sintered compact of experiment No.317, where a conduction via is formed, has an an electrical connection with the substrate surface which is not formed, it was confirmed that there is not only mechanical junction nature but also electrical connection between the thin film conductivity material created in this Example and the thin film which comprises as the main ingredients at least one or more materials selected from a gallium nitride, an indium nitride, and an aluminum nitride.

These results were described in Table 17.

In the thin film conductivity material produced in this Example, electric resistivitys of titanium, chromium, nickel, molybdenum, tungsten, platinum, aluminum, tantalum, titanium nitride, gold, and copper are not more than 1×10⁻³ Ω·cm altogether in room temperature, since it has higher conductivity than the electrical conductive thin film of various compositions which comprises as the main ingredients at least one or more materials selected from a gallium nitride, an indium nitride, and an aluminum nitride and is obtained by adding a doping agent, still higher electrical connection nature is obtained using the thin film conductivity material according to this invention, between the electrical conductive thin film which comprises as the main ingredients at least one or more materials selected from a gallium nitride, an indium nitride, and an aluminum nitride and the substrate surface on which this thin film is not formed.

Moreover, if functional elements, such as a light emitting device, are formed on this substrate for thin film formation, for example, using the substrate for thin film formation on which the thin film conductivity material according to this invention was formed as an electric circuit pattern, it functions also as the circuit board for mounting a light emitting device, or a substrate unified as a package.

Therefore, although the circuit board or package for mounting a functional element, such as a light emitting device, is required usually, the effect of it becoming unnecessary to prepare a wiring board or a package independently is acquired, if using the substrate with which the function was united according to this invention.

Each above-mentioned result was collectively shown in Table 17.

### EXAMPLE 19

High purity aluminum nitride powder (grade “H” by Tokuyama Soda Co., Ltd. (present: Tokuyama, Inc.)) was prepared as raw material powder for sintered compact production.

This raw material powder is manufactured in method of oxide reduction.

This raw material powder contains oxygen 0.8 weight % as impurities.

After a rare earth element compound, an alkaline-earth-metals compound, alumina, a transition metal compound, an alkali metal compound, and a silicon compound, etc. are suitably added to this raw material powder, it mixes by a ball mill with ethanol for 24 hours, and it was dried and ethanol was vaporized, then paraffine wax was added to mixed powder 5 weight %, the powder for molding was produced, and the powder compact of round shape with a diameter of 36 mm×thickness of 2.0 mm was acquired by uniaxial press molding.

After that, paraffine wax was degreased under decompression at 300 degrees C., the powder compact of the various compositions which is the fired thing is put into the setter and saggar made from an aluminum nitride, or the above-mentioned fired thing is put into the setter and saggar made from tungsten, the setter and saggar made from BN, and the setter and saggar made from carbon which carried out coating of the boron nitride powder to the surface, the powder compact which consists only of an aluminum nitride independently prepared is placed simultaneously on this setter and in the saggar, and normal pressure sintering is carried out in nitrogen atmosphere, then the sintered compact of various compositions which comprises an aluminum nitride as the main ingredients was obtained.

The powder compact which added a rare earth element compound and an alkaline-earth-metals compound as sintering aid was fired at 1800 degrees C. for 2 hours.

The powder compact which does not add a rare earth element compound and an alkaline-earth-metals compound was fired at 1950 degrees C. for 2 hours.

All the obtained sintered compacts are made dense to not less than 95% of relative density.

Next, the obtained sintered compact is grinding to a size with a diameter of 25.4 mm×thickness of 0.5 mm, mirror polish processing of the surface is carried out by the same method using the abradant which comprises as the main ingredients chromic oxide of 0.2 μm of particle diameter as Example 8, as for the various sintered compacts which comprise an aluminum nitride as the main ingredients, the total amount of oxygen, the amount of ALON, and the optical transmissivity to the light with a wavelength 605 nm were measured by the same method as Example 2.

Measurement of thermal conductivity was also performed with some samples.

This measurement result is shown in Table 18-Table 23.

As for the obtained various sintered compacts which comprise an aluminum nitride as the main ingredients, in this Example, the quantity of the impurities or added various additives which are contained in a powder compact is what converted the impurities actually contained or the compounds actually added to oxide or element.

In the sintered compact which comprises an aluminum nitride as the main ingredients and was produced in this Example, it was confirmed that impurities oxygen in raw material powder and the oxygen ingredient resulting from added Al₂O₃, or the metal ingredient and the oxygen ingredient, etc. in sintering aids, such as an added rare earth element compound and an alkaline-earth-metals compound, or the metal ingredient and the oxygen ingredient, etc. in the alkali metal compound and silicon content compound which were added, or the metal ingredient and carbon ingredient, etc. in the compound containing each transition metal of Mo, W, V, Nb, Ta, and Ti and the compound containing carbon which were added, or the metal ingredient, etc. in the compound containing unescapable metal, such as Fe, Ni, Cr, Mn, Zr, Hf, Co, Cu, and Zn, etc. which were added, are hardly vaporized and removed by firing, either, but the almost same quantity as the quantity in a powder compact exist.

That is, when the above-mentioned converted value was used as an amount of impurities and an amount of additives, since the quantity of the impurities or the additives in the sintered compact which comprises an aluminum nitride as the main ingredients and was produced in this Example has a small difference with the quantity of the impurities or the additives contained in a powder compact, it can be considered that it is almost the same amount.

Therefore, as the obtained composition of a sintered compact which comprises an aluminum nitride as the main ingredients, it is not indicated especially except the total amount of oxygen in each Table.

Al₂O₃ quantity added when producing the above-mentioned sintered compact which comprises an aluminum nitride as the main ingredients is calculated by oxide conversion (that is, not especially converting, quantity as it is), and the amount of oxygen in the sintered compact which comprises an aluminum nitride as the main ingredients is measured by element conversion. The example in which Al₂O₃ was used alone as an additive and the example in which Al₂O₃ and a rare earth element compound, or an alkaline-earth-metals compound were added simultaneously are shown in Table 18.

The example in which a rare earth element compound and an alkaline-earth-metals compound were used respectively alone or simultaneously as an additive is shown in Table 19.

The measurement result of the thermal conductivity in room temperature is also shown in the example of an experiment of Table 19.

The example in which the silicon content compound and the alkali metal compound were used as an additive is shown in Table 20.

And, the example in which a silicon content compound and a rare earth element compound, or an alkaline-earth-metals compound were added simultaneously is also shown in Table 20.

And, the example in which an alkali metal compound and a rare earth element compound, or an alkaline-earth-metals compound were added simultaneously is also shown in Table 20.

The example in which each transition metal ingredient of Mo, W, V, Nb, Ta, and Ti, and the carbon were used as an additive is shown in Table 21.

The example in which each transition metal ingredient of Mo, W, V, Nb, Ta, and Ti and the carbon, and a rare earth element compound, or an alkaline-earth-metals compound were added simultaneously is shown in Table 22.

The example in which each ingredient of iron, nickel, chromium, manganese, zirconium, hafnium, cobalt, copper, and zinc was used as an additive is shown in Table 23.

The example in which each ingredient of iron, nickel, chromium, manganese, zirconium, hafnium, cobalt, copper, and zinc, and a rare earth element compound, or an alkaline-earth-metals compound were used simultaneously is also shown in Table 23.

After specular surface polish, as for the surface smooth nature of the sintered compact which comprises an aluminum nitride as the main ingredients, it was the range of average surface roughness (Ra)=31 nm-36 nm.

As shown in Table 18-23, in this Example, the sintered compact which comprises an aluminum nitride as the main ingredients and whose optical transmissivity is not more than 50% was obtained except for experiment No.396.

And, what contains comparatively a lot of oxygen (it used as Al₂O₃), or a rare earth element compound and an alkaline-earth-metals compound, or a silicon content compound and an alkali metal compound, or Mo, W, V, Nb, Ta, Ti, and carbon, or iron, nickel, chromium, manganese, zirconium, hafnium, cobalt, copper, zinc tends to lower to optical transmissivity not more than 10%, the thing whose optical transmissivity is 0% was also obtained easily.

As for the sintered compact which comprises an aluminum nitride as the main ingredients and was produced in the experimental example shown in Table 19, in all the things belonging to the range of this invention, the thermal conductivity was not less than 50 W/mK in room temperature, and it was a maximum of 177 W/mK.

Next, by using the obtained sintered compact which comprises an aluminum nitride as the main ingredients as a substrate, the thin film which comprises as the main ingredients a gallium nitride, an indium nitride, and an aluminum nitride was formed on the substrate surface by the method using the same MOCVD (Metal Organic Chemical Vapor Deposition) equipment by the high frequency induction heating as Example 1 and Example 2.

The obtained thin film performed crystalline evaluation by X ray diffraction which used CuKα characteristic X-rays.

Consequently, in the example of an experiment using Al₂O₃ as an additive agent shown in Table 18, in the case of the sintered compact which comprises an aluminum nitride as the main ingredients and whose amount of ALON is not more than 7%, the single crystal thin film which has the crystallinity not more than 200 seconds as half width of the rocking curve of the X ray diffraction line from the lattice plane of a Miller Index (002) and comprises as the main ingredients a gallium nitride, an indium nitride, and an aluminum nitride has been formed as shown in Table 18.

And, in the case of the sintered compact which comprises an aluminum nitride as the main ingredients and whose amount of ALON is not more than 12%, the single crystal thin film which has the crystallinity not more than 240 seconds as half width of the rocking curve of the X ray diffraction line from the lattice plane of a Miller Index (002) and comprises as the main ingredients a gallium nitride, an indium nitride, and an aluminum nitride has been formed.

And, in the case of the sintered compact which comprises an aluminum nitride as the main ingredients and whose amount of ALON is not more than 20%, the single crystal thin film which has the crystallinity not more than 300 seconds as half width of the rocking curve of the X ray diffraction line from the lattice plane of a Miller Index (002) and comprises as the main ingredients a gallium nitride, an indium nitride, and an aluminum nitride has been formed.

And, in the case of the sintered compact which comprises an aluminum nitride as the main ingredients and whose amount of oxygen is not more than 3 weight %, the single crystal thin film which has the crystallinity not more than 200 seconds as half width of the rocking curve of the X ray diffraction line from the lattice plane of a Miller Index (002) and comprises as the main ingredients a gallium nitride, an indium nitride, and an aluminum nitride has been formed.

And, in the case of the sintered compact which comprises an aluminum nitride as the main ingredients and whose amount of oxygen is not more than 5 weight %, the single crystal thin film which has the crystallinity not more than 240 seconds as half width of the rocking curve of the X ray diffraction line from the lattice plane of a Miller Index (002) and comprises as the main ingredients a gallium nitride, an indium nitride, and an aluminum nitride has been formed.

And, in the case of the sintered compact which comprises an aluminum nitride as the main ingredients and whose amount of oxygen is not more than 10 weight %, the single crystal thin film which has the crystallinity not more than 300 seconds as half width of the rocking curve of the X ray diffraction line from the lattice plane of a Miller Index (002) and comprises as the main ingredients a gallium nitride, an indium nitride, and an aluminum nitride has been formed.

The content of ALON also increases as the total amount of oxygen in the sintered compact which comprises an aluminum nitride as the main ingredients increases, if the total amount of oxygen increases more than 10 weight %, although the content of ALON will also increase more than 20%, the single crystal thin film which comprises as the main ingredients a gallium nitride, an indium nitride, and an aluminum nitride has been formed.

Furthermore, if the total amount of oxygen in the sintered compact which comprises an aluminum nitride as the main ingredients increases more than 25 weight %, the content of ALON will also increase more than 50%, the thin film which comprises as the main ingredients a gallium nitride, an indium nitride, and an aluminum nitride and is formed on the sintered compact which comprises an aluminum nitride as the main ingredients tends to become to polycrystalline state, formation of a single crystal thin film tends to become difficult.

Moreover, if the sintered compact which comprises an aluminum nitride as the main ingredients and was produced by adding simultaneously a rare earth element compound or an alkaline-earth-metals compound was used, it was confirmed that the crystallinity of the formed single crystal thin film which comprises as the main ingredients a gallium nitride, an indium nitride, and an aluminum nitride improves than what added Al₂O₃ alone.

And, in the example of an experiment using a rare earth element compound and an alkaline-earth-metals compound which are shown in Table 19 as an additive agent, if the content of a rare earth element ingredient in the sintered compact which comprises an aluminum nitride as the main ingredients is up to 7 volume % by oxide conversion, the single crystal thin film which has the crystallinity not more than 200 seconds as half width of the rocking curve of the X ray diffraction line from the lattice plane of a Miller Index (002) and comprises as the main ingredients a gallium nitride, an indium nitride, and an aluminum nitride has been formed.

And, if the content of a rare earth element ingredient is up to 12 volume % by oxide conversion, the single crystal thin film which has the crystallinity not more than 240 seconds as half width of the rocking curve of the X ray diffraction line from the lattice plane of a Miller Index (002) and comprises as the main ingredients a gallium nitride, an indium nitride, and an aluminum nitride has been formed.

And, if the content of a rare earth element ingredient is up to 25 volume % by oxide conversion, the single crystal thin film which has the crystallinity not more than 300 seconds as half width of the rocking curve of the X ray diffraction line from the lattice plane of a Miller Index (002) and comprises as the main ingredients a gallium nitride, an indium nitride, and an aluminum nitride has been formed.

And, if the content of an alkaline-earth-metals ingredient in the sintered compact which comprises an aluminum nitride as the main ingredients is up to 3 volume % by oxide conversion, the single crystal thin film which has the crystallinity not more than 200 seconds as half width of the rocking curve of the X ray diffraction line from the lattice plane of a Miller Index (002) and comprises as the main ingredients a gallium nitride, an indium nitride, and an aluminum nitride has been formed.

And, if the content of an alkaline-earth-metals ingredient in the sintered compact which comprises an aluminum nitride as the main ingredients is up to 5 volume % by oxide conversion, the single crystal thin film which has the crystallinity not more than 240 seconds as half width of the rocking curve of the X ray diffraction line from the lattice plane of a Miller Index (002) and comprises as the main ingredients a gallium nitride, an indium nitride, and an aluminum nitride has been formed.

And, if the content of a rare earth element compound and an alkaline-earth-metals ingredient in the sintered compact which comprises an aluminum nitride as the main ingredients is up to 25 volume % respectively by oxide conversion, the single crystal thin film which has the crystallinity not more than 300 seconds as half width of the rocking curve of the X ray diffraction line from the lattice plane of a Miller Index (002) and comprises as the main ingredients a gallium nitride, an indium nitride, and an aluminum nitride has been formed.

There is a tendency that the crystallinity of the single crystal thin film which comprises as the main ingredients a gallium nitride, an indium nitride, and an aluminum nitride decreases, as the content of a rare earth element ingredient in a sintered compact and an alkaline-earth-metals ingredient increases.

If the content of a rare earth element ingredient, and an alkaline-earth-metals ingredient in the sintered compact which comprises an aluminum nitride as the main ingredients increases more than 50 volume % respectively by oxide conversion, the thin film which comprises as the main ingredients a gallium nitride, an indium nitride, and an aluminum nitridey tends to become to polycrystalline state, formation of a single crystal thin film tends to become difficult.

And, if it is the same amount of addition, when the sintered compact which comprises an aluminum nitride as the main ingredients and was produced by adding a rare earth element compound or an alkaline-earth-metals compound simultaneously was used, it was confirmed that the crystallinity of the single crystal thin film which comprises as the main ingredients a gallium nitride, an indium nitride, and an aluminum nitride improves than what added a rare earth element compound and an alkaline-earth-metals compound alone respectively.

In the example of an experiment shown in Table 20 and using an alkaline metal compound and a silicon compound as an additive agent, if the content of an alkaline metal and a silicon ingredient in the sintered compact which comprises an aluminum nitride as the main ingredients is up to 5 volume % respectively by oxide conversion, the single crystal thin film which has the crystallinity not more than 240 seconds as half width of the rocking curve of the X ray diffraction line from the lattice plane of a Miller Index (002) and comprises as the main ingredients a gallium nitride, an indium nitride, and an aluminum nitride has been formed.

And, if the content of an alkaline metal and a silicon ingredient in the sintered compact which comprises an aluminum nitride as the main ingredients is up to 10 volume % respectively by oxide conversion, the single crystal thin film which has the crystallinity not more than 300 seconds as half width of the rocking curve of the X ray diffraction line from the lattice plane of a Miller Index (002) and comprises as the main ingredients a gallium nitride, an indium nitride, and an aluminum nitride has been formed.

There is a tendency that the crystallinity of the single crystal thin film which comprises as the main ingredients a gallium nitride, an indium nitride, and an aluminum nitride decreases as the content of an alkaline metal ingredient and a silicon ingredient in a sintered compact increases.

If the content of an alkaline metal ingredient and a silicon ingredient in the sintered compact which comprises an aluminum nitride as the main ingredients increases more than 20 volume % respectively by oxide conversion, the thin film which comprises as the main ingredients a gallium nitride, an indium nitride, and an aluminum nitride will become to polycrystalline state, and formation of a single crystal thin film will tend to become difficult.

Moreover, it was confirmed that if the sintered compact which comprises an aluminum nitride as the main ingredients and was produced by adding simultaneously a rare earth element compound or an alkaline-earth-metals compound was used, the crystallinity of the formed single crystal thin film which comprises as the main ingredients a gallium nitride, an indium nitride, and an aluminum nitride improves than what added an alkaline metal ingredient and a silicon ingredient alone, respectively.

In the example of an experiment shown in Table 21 and using each transition metal ingredient of Mo, W, V, Nb, Ta, and Ti and carbon as an additive agent, if the content of each transition metal ingredient of Mo, W, V, Nb, Ta, and Ti and carbon in the sintered compact which comprises an aluminum nitride as the main ingredients is up to 5 volume % respectively by element conversion, the single crystal thin film which has the crystallinity not more than 200 seconds as half width of the rocking curve of the X ray diffraction line from the lattice plane of a Miller Index (002) and comprises as the main ingredients a gallium nitride, an indium nitride, and an aluminum nitride has been formed.

And, if the content of each transition metal ingredient of Mo, W, V, Nb, Ta, and Ti and carbon in the sintered compact which comprises an aluminum nitride as the main ingredients is up to 10 volume % respectively by element conversion, the single crystal thin film which has the crystallinity not more than 240 seconds as half width of the rocking curve of the X ray diffraction line from the lattice plane of a Miller Index (002) and comprises as the main ingredients a gallium nitride, an indium nitride, and an aluminum nitride has been formed.

And, if the content of each transition metal ingredient of Mo, W, V, Nb, Ta, and Ti and carbon in the sintered compact which comprises an aluminum nitride as the main ingredients is up to 25 volume % respectively by element conversion, the single crystal thin film which has the crystallinity not more than 300 seconds as half width of the rocking curve of the X ray diffraction line from the lattice plane of a Miller Index (002) and comprises as the main ingredients a gallium nitride, an indium nitride, and an aluminum nitride has been formed.

There is a tendency that the crystallinity of the single crystal thin film which comprises as the main ingredients a gallium nitride, an indium nitride, and an aluminum nitride decreases as the content of each transition metal ingredient of Mo, W, V, Nb, Ta, and Ti and carbon in a sintered compact increases.

If the content of each transition metal ingredient of Mo, W, V, Nb, Ta, and Ti and carbon in the sintered compact which comprises an aluminum nitride as the main ingredients increases more than 50 volume % respectively by element conversion, the thin film which comprises as the main ingredients a gallium nitride, an indium nitride, and an aluminum nitride will become to polycrystalline state, and formation of a single crystal thin film will tend to become difficult.

In the example of an experiment shown in Table 22 and in which each transition metal ingredient of Mo, W, V, Nb, Ta, and Ti and carbon, and a rare earth element compound, or an alkaline-earth-metals compound were added simultaneously as an additive agent, even if the sintered compact which comprises an aluminum nitride as the main ingredients is what contains each ingredient each transition metal ingredient of Mo, W, V, Nb, Ta, and Ti and carbon comparatively so much up to 25 volume % by element conversion, respectively, the single crystal thin film which comprises as the main ingredients a gallium nitride, an indium nitride, and an aluminum nitride and has the crystallinity not more than 240 seconds as half width of the rocking curve of the X ray diffraction line from the lattice plane of a Miller Index (002) can be formed, and improvement of the crystallinity was confirmed clearly.

In the example of an experiment shown in Table 23 and using each ingredient of iron, nickel, chromium, manganese, zirconium, hafnium, cobalt, copper, and zinc as an additive agent, if the content of each transition metal ingredient of iron, nickel, chromium, manganese, zirconium, hafnium, cobalt, copper, and zinc in the sintered compact which comprises an aluminum nitride as the main ingredients is up to 10 weight % respectively by element conversion, the single crystal thin film which has the crystallinity not more than 200 seconds as half width of the rocking curve of the X ray diffraction line from the lattice plane of a Miller Index (002) and comprises as the main ingredients a gallium nitride, an indium nitride, and an aluminum nitride has been formed.

And, if the content of each transition metal ingredient of iron, nickel, chromium, manganese, zirconium, hafnium, cobalt, copper, and zinc in the sintered compact which comprises an aluminum nitride as the main ingredients is up to 20 weight % respectively by element conversion, the single crystal thin film which has the crystallinity not more than 240 seconds as half width of the rocking curve of the X ray diffraction line from the lattice plane of a Miller Index (002) and comprises as the main ingredients a gallium nitride, an indium nitride, and an aluminum nitride has been formed.

And, if the content of each transition metal ingredient of iron, nickel, chromium, manganese, zirconium, hafnium, cobalt, copper, and zinc in the sintered compact which comprises an aluminum nitride as the main ingredients is up to 30 weight % respectively by element conversion, the single crystal thin film which has the crystallinity not more than 300 seconds as half width of the rocking curve of the X ray diffraction line from the lattice plane of a Miller Index (002) and comprises as the main ingredients a gallium nitride, an indium nitride, and an aluminum nitride has been formed.

There is a tendency that the crystallinity of the single crystal thin film which comprises as the main ingredients a gallium nitride, an indium nitride, and an aluminum nitride decreases as the content of each transition metal ingredient of iron, nickel, chromium, manganese, zirconium, hafnium, cobalt, copper, and zinc in a sintered compact increases.

If the content of each transition metal ingredient of iron, nickel, chromium, manganese, zirconium, hafnium, cobalt, copper, and zinc in the sintered compact which comprises an aluminum nitride as the main ingredients increases more than 50 weight % respectively by element conversion, the thin film which comprises as the main ingredients a gallium nitride, an indium nitride, and an aluminum nitride will become to polycrystalline state, and formation of a single crystal thin film will tend to become difficult.

And, if the sintered compact which comprises an aluminum nitride as the main ingredients and was produced by adding simultaneously a rare earth element compound or an alkaline-earth-metals compound was used, it was confirmed that the crystallinity of the formed single crystal thin film which comprises as the main ingredients a gallium nitride, an indium nitride, and an aluminum nitride improves than what added each transition metal ingredient of iron, nickel, chromium, manganese, zirconium, hafnium, cobalt, copper, and zinc alone respectively.

In the thin films obtained in this Example, observation of the single crystal thin film was performed using the optical microscope and the electron microscope, consequently, a crack was not seen in the inside of single crystal thin films, and exfoliation at a junction interface between the single crystal thin films and the sintered compact which comprises an aluminum nitride as the main ingredients is not seen.

Although junction nature was tested by the method of pasting up pressure sensitive adhesive tape on the obtained above-mentioned single crystal thin film, and tearing off the tape, the exfoliation or the destruction between this single crystal thin film and the sintered compact which comprises an aluminum nitride as the main ingredients was not seen.

### EXAMPLE 20

Using the thing which was processed into the shape of a substrate of a size with a diameter of 25.4 mm×thickness of 0.5 mm and whose specular surface polish was carried out about the sintered compact which was used in Example 18 and which has a conduction via and comprises an aluminum nitride as the main ingredients, the sintered compact without conduction via which comprises an aluminum nitride as the main ingredients, and each sintered compact of experiment No.265, experiment No.269, and experiment No.271 which was produced in Example 11 and raised the purity of an aluminum nitride, the thin film which has various compositions and various crystallized states and which comprises as the main ingredients at least one or more materials selected from a gallium nitride, an indium nitride, and an aluminum nitride was formed in the thickness of 3 μm on one surface of each above-mentioned sintered compact by the same method as Example 1, Example 2, Example 10, and Example 12, and various thin film substrates were produced.

It is as composition and the crystallized state of this thin film being shown in Table 24.

Furthermore, in the other, the thin film substrate on which the thin film which comprises as the main ingredients at least one or more materials selected from a gallium nitride, an indium nitride, and an aluminum nitride was formed furthermore on the substrate which consists of a sintered compact on which various conductive material, such as titanium, chromium, nickel, molybdenum, tungsten, platinum, aluminum, tantalum, nitriding tantalum, nitriding titanium, gold, copper, tungsten/copper alloy (W: 90 weight %+Cu 10 weight %), etc. produced in Example 18, was formed beforehand which comprises an aluminum nitride as the main ingredients, was also prepared.

Although the thin film composition and crystallized state were the same as Example 18 about the thin film substrate produced in Example 18, it re-published in Table 25 anew.

Next, by using the thin film substrate produced or prepared as mentioned above, the various thin film conductivity materials which consist of titanium, chromium, nickel, molybdenum, tungsten, platinum, aluminum, tantalum, tantalum nitride, titanium nitride, gold, and copper, etc. by the same method as Example 18 was formed on the thin film which is being formed on this thin film substrate and which comprises as the main ingredients at least one or more materials selected from a gallium nitride, an indium nitride, and an aluminum nitride.

It is as the constitution and thickness of these various thin film conductivity materials having been indicated in Table 24 and 25.

After forming various thin film conductivity materials, observation of appearance was performed about the thin film which is being formed on the used thin film substrate and which comprises as the main ingredients at least one or more materials selected from a gallium nitride, an indium nitride, and an aluminum nitride, consequently, especially faults, such as a crack and exfoliation in an interface with thin film conductivity material, are not found, but are in a good appearance state, it was confirmed that the thin film conductivity material which used the material according to this invention has good junction nature to the thin films of various compositions which comprises as the main ingredients at least one or more materials selected from a gallium nitride, an indium nitride, and an aluminum nitride.

In order to confirm junction nature between the thin film conductivity material and the thin film of various compositions which comprises as the main ingredients at least one or more materials selected from a gallium nitride, an indium nitride, and an aluminum nitride, the next test was performed furthermore.

As the testing method, the circular aluminum pin with a diameter of 3 mm was pasted up on the produced substrate by epoxy resin, and perpendicular tensile strength was measured, all are not less than 2 Kg/mm² as perpendicular tensile strength.

Exfoliation exists in an adhesion interface between epoxy resin and the thin film of various compositions which comprises as the main ingredients at least one or more materials selected from a gallium nitride, an indium nitride, and an aluminum nitride, or in the adhesion interface between the epoxy resin and the pin, or in the inside of an epoxy resin, it was confirmed that the exfoliation or destruction between the thin film conductivity material and the thin films of various compositions which comprises as the main ingredients at least one or more materials selected from a gallium nitride, an indium nitride, and an aluminum nitride are not seen, but good junction nature is formed.

In addition, in the formed thin film conductivity material, as for what is the constitution of having gold and copper on the surface (each sample of experiment No.494-497, 500, 502-504, and 512-515), by using the lead made from kovar which has a pad with a diameter of 1.5 mm at a tip, this lead and thin film conductivity material were connected with solder, and perpendicular tensile strength was measured.

Consequently, all are not less than 4 Kg/mm² as perpendicular tensile strength, after testing the leads and the portions of the thin film substrates to which the leads were joined were observed, all were being destroyed in the inside of solder or at the portion between solder and the lead, the exfoliation or destruction between the thin film which comprises as the main ingredients at least one or more materials selected from a gallium nitride, an indium nitride, and an aluminum nitride and the thin film conductivity material were not observed.

Therefore, the junction strength between the thin film conductivity material and the above-mentioned thin film is originally not less than 4 Kg/mm², it was confirmed that the junction nature is what is high.

Furthermore, although junction nature was tested by the method of pasting up pressure sensitive adhesive tape on the thin film conductivity material currently formed on the surface of produced substrate, and tearing off the tape, the exfoliations or the destructions between the thin film conductivity materials and the thin films of various compositions which comprise as the main ingredients at least one or more materials selected from a gallium nitride, an indium nitride, and an aluminum nitride were not seen altogether.

The above-mentioned examination resultlt is proving that not only junction nature between the thin film conductivity material and the thin film which comprises as the main ingredients at least one or more materials selected from a gallium nitride, an indium nitride, and an aluminum nitride is high but also junction nature between the sintered compact which comprises an aluminum nitride as the main ingredients and the thin film conductivity material, and junction nature between the sintered compact which comprises an aluminum nitride as the main ingredients and the thin film which comprises as the main ingredients at least one or more materials selected from a gallium nitride, an indium nitride, and an aluminum nitride is also what is high.

These results were described in Table 24 and Table 25.

And, also in this invention, the thin film which have the conductivity and which comprises as the main ingredients at least one or more materials selected from a gallium nitride, an indium nitride, an aluminum nitride and was produced by using the sintered compact of experiment No.73, the sintered compact of experiment No.75, the sintered compact of experiment No.80, the sintered compact of experiment No.82, the sintered compact of experiment No.305, the sintered compact of experiment No.311, and the sintered compact of experiment No.317 in which the conduction via is formed has an electrical connection with the substrate surface in which this thin film is not formed, it was confirmed that there is not only mechanical junction nature but also electrical connection between the thin film conductivity material created in this Example and the thin film which comprises as the main ingredients at least one or more materials selected from a gallium nitride, an indium nitride, and an aluminum nitride.

In the thin film conductivity material produced in this Example, electric resistivitys of titanium, chromium, nickel, molybdenum, tungsten, platinum, aluminum, tantalum, titanium nitride, gold, and copper are not more than 1×10⁻³ Ω·cm in room temperature altogether, since it has conductivity higher than the electrical conductive thin film of various compositions which comprises as the main ingredients at least one or more materials selected from a gallium nitride, an indium nitride, and an aluminum nitride, obtained by adding a doping agent etc., high electrical connection nature is obtained by using the thin film conductivity material according to this invention, between the electrical conductive thin film of various compositions which comprises as the main ingredients at least one or more materials selected from a gallium nitride, an indium nitride, and an aluminum nitride and the substrate surface in which this thin film is not formed.

And, if functional elements, such as a light emitting device, are formed on the substrate for thin film formation on which the thin film conductivity material according to this invention was formed as an electric circuit pattern, for example, on this substrate for thin film formation, it functions also as the circuit board for mounting a light emitting device, or a substrate unified as a package.

Therefore, although the circuit board or package for mounting a functional element, such as a light emitting device, is required usually, the effect of it becoming unnecessary to prepare a wiring board or a package independently is acquired, if using the substrate with which the function was united according to this invention.

### EXAMPLE 21

Each sintered compact which comprises an aluminum nitride as the main ingredients, such that that is the thing of experiment No.49 and experiment No.58 which was produced in Example 2 and the thing of experiment No.269 which was produced in Example 11, was processed in the shape of a substrate of the size with a diameter of 25.4 mm×thickness of 0.5 mm, and specular surface polish was carried out further, then the thin film of various compositions which comprises as the main ingredients at least one or more materials selected from a gallium nitride, an indium nitride, and an aluminum nitride was formed in the thickness of 6 μm on it by the same MOCVD method as having used in Example 1, Example 2, Example 10, and Example 12, and the thin film substrate was produced.

And, the thin film of various compositions which contains niobium and tantalum and comprises as the main ingredients at least one or more materials selected from a gallium nitride, an indium nitride, and an aluminum nitride was also formed.

The thin film containing niobium and tantalum was formed in the thickness of 6 μm by the same Chloride VPE method as Example 9.

A niobium chloride and a tantalum chloride were used as a raw material of the ingredient of niobium, and tantalum.

These thin films were formed so that it might become into each crystallized state of a single crystal, an amorphous state, and an orientated polycrystal.

When forming a single crystal thin film, the substrate on which the orientated polycrystalline thin film which has the direction where C axis is perpendicular to this substrate surface and which consists of 100 mol % AlN composition substantially was formed beforehand on all the substrates which consist of a sintered compact which comprises an aluminum nitride as the main ingredients by the above described MOCVD method was used.

As for the single crystal thin film formed on such an orientated polycrystalline thin film, it produced two kinds of what formed the direction of a crystal C axis perpendicularly and what formed in horizontally to the substrate surface,

The thin film of each crystallized state of an amorphous state, and an orientated polycrystal other than a single crystal was formed directly on the substrate which consists of a sintered compact which comprises an aluminum nitride as the main ingredients as it.

An orientated polycrystalline thin film is formed so that C axis may become perpendicular to a substrate surface (experiment No. 546, 548).

Although the appearance of each formed thin film was observed, faults, such as a crack in a thin film and an exfoliation between the sintered compacts which comprise an aluminum nitride as the main ingredients, were not seen.

There was no exfoliation between the sintered compacts which comprise an aluminum nitride as the main ingredients and the thin film formed although the exfoliation test was performed using pressure sensitive adhesive tape.

The half width of the rocking curve of the X ray diffraction line from the lattice plane of the Miller Index (002) of the orientated polycrystal AlN thin film first formed on the above-mentioned substrate which consists of a sintered compact which comprises an aluminum nitride as the main ingredients was in the range of 4270-4740 seconds.

On the other hand, as for the crystallinity of the single crystal thin film formed on the above-mentioned orientated polycrystalline thin film, the half width of the rocking curve of the X ray diffraction line from the lattice plane of a Miller Index (002) was not more than 300 seconds.

Next, the refractive index of the formed thin film to the light of 650 nm wavelength was investigated by using the spectrophotometer (Spectrophotometer) “product name: FilmTek4000” made from U.S. “SCI (Scientific Computing International) Co.”.

The refractive index of a direction parallel to C axis (namely, extraordinary light) was measured as the refractive index of the thin film in which the crystal C axis of a single crystal thin film was formed perpendicularly to the substrate surface, and the refractive index of a direction perpendicular to C axis (namely, ordinary light) was measured as the refractive index of the thin film in which the crystal C axis of a single crystal thin film was formed horizontally to the substrate surface.

Consequently, in the thin film which comprises as the main ingredients at least one or more materials selected from a gallium nitride, an indium nitride, and an aluminum nitride, in the thin film of which crystallized state of a single crystal and an amorphous state, it was confirmed that the refractive index becomes large if increasing the content of a gallium nitride or an indium nitride and tends to decrease if increasing the content of an aluminum nitride without depending on the formation direction of the crystal C axis in a single crystal thin film.

It was found out that if the content of niobium or tantalum increases, a refractive index becomes large.

In the formed thin film, if the amount of increases of at least one or more ingredients selected from a gallium nitride and an indium nitride which are contained in what comprises an aluminum nitride as the main ingredients is more than 0.01 mol % to the main ingredients, the increase of a refractive index is observed at least not less than 1×10⁻⁵, if it is at least not more than 20 mol %, the increase of a refractive index was not more than 2×10⁻¹.

Moreover, in the formed thin film which comprises as the main ingredients at least one or more materials selected from a gallium nitride, an indium nitride, and an aluminum nitride, if the content of at least one or more ingredients selected from niobium and tantalum is not less than 0.01 mol % to the main ingredients, the increase of a refractive index is observed at least not less than 1×10⁻⁵, if it is at least not more than 20 mol %, the increase of a refractive index was not more than 2×10⁻¹.

Moreover, the refractive index of the single crystal thin film of which C axis was horizontally formed to the substrate surface is smaller than what was formed perpendicularly about 0.03-0.05.

Moreover, although there was a tendency where the refractive index of the thin film of a polycrystal is larger than an amorphous state, it was not more than 2.0 in what is a crystallized state of both, and it was smaller than a single crystal.

Although the thin film was formed on the thin film substrate produced in experiment No.549-577 by a Chloride VPE method, even if it was the thin film of the same composition, the refractive index differs from the thin film which was formed by the MOCVD method each other, the tendency in which the refractive index of the thin film produced by the Chloride VPE method becomes large was shown.

These results are shown in Table 26.

In Table 26, the ingredient of niobium, and tantalum was described by regarding as niobium nitride and tantalum nitride.

### COMPARATIVE EXAMPLE

In the other, preparing the substrate which consists of a sintered compact which comprises an aluminum nitride as the main ingredients produced by experiment No.49 of this above-mentioned Example, some substrates are left as it is, on some substrates, the 100 mol % AlN orientated polycrystalline thin film was formed on the same conditions as this Example.

LiNbO₃, SiO₂, and an Al₂O₃ thin film with a thickness of 6.0 μm were formed on these substrates after that by the radio frequency (RF) magnetron sputtering method with a frequency of 13.56 MHz.

The sputtering was performed on the condition where the substrate temperature was 250 degrees C., the Ar gas pressure was 0.6 Pa, and electric power was 1000 W.

Consequently, irrespective of the existence of formation of a 100 mol % AlN orientated polycrystalline thin film, a crack arose in any thin film of LiNbO₃, SiO₂, and Al₂O₃, it was difficult to use it as an optical waveguide.

### EXAMPLE 22

Sintered compacts which comprise an aluminum nitride as the main ingredients, such that they are the things of experiment No.49 and experiment No.58 which were produced in Example 2 and the thing of experiment No.269 which was produced in Example 11, was processed in the shape of a substrate of a size with a diameter of 25.4 mm×thickness of 0.5 mm, and specular surface polish was carried out further, the thin film substrate on which the thin film of various compositions and various crystallized states which comprises as the main ingredients at least one or more materials selected from a gallium nitride, an indium nitride, and an aluminum nitride was formed on it by the same MOCVD method and Chloride VPE method as having used in Example 1, Example 2, Example 4, Example 9, Example 12, and Example 21 was produced.

The thickness of the thin film produced by the MOCVD method is 25 μm, and the thickness of the thin film produced by the Chloride VPE method is 100 μm.

On the occasion of formation of 3 ingredient mixed crystal thin film of AlN+GaN+InN, it carried out with the substrate temperature of 950 degrees C.

And, when forming a single crystal thin film, the substrate on which the orientated polycrystalline thin film which has the direction where C axis is perpendicular to this substrate surface and which consists of 100 mol % AlN composition substantially was formed beforehand on all the substrates which consist of a sintered compact which comprises an aluminum nitride as the main ingredients by the radio frequency (RF) magnetron sputtering method with a frequency of 13.56 MHz was used.

As for the conditions of sputtering, a high purity AlN sintered compact was used as a target, the mixed gas of Ar+N₂ was introduced with the mixture ratio of N₂/Ar=0.4, the pressure inside the chamber was 0.8 Pa, and electric power was 1000 W.

The thin film of each crystallized state of an amorphous state and an orientated polycrystal other than a single crystal was formed directly on the substrate which consists of a sintered compact which comprises an aluminum nitride as the main ingredients as it is.

An orientated polycrystalline thin film was formed so that C axis might become perpendicular to a substrate surface.

And, the single crystal thin films were formed so that C axis might become perpendicular to a substrate surface altogether.

The half width of the rocking curve of the X ray diffraction line from the lattice plane of the Miller Index (002) of the orientated polycrystal AlN thin film first formed on the above-mentioned substrate which consists of a sintered compact which comprises an aluminum nitride as the main ingredients was in the range of 6440 seconds-7190 seconds.

Although the appearance of each formed thin film was observed, faults, such as the crack in a thin film and the exfoliation between the sintered compacts which comprise an aluminum nitride as the main ingredients, were not seen.

There was no exfoliation between the formed thin films and the sintered compacts which comprise an aluminum nitride as the main ingredients although the exfoliation test was performed using pressure sensitive adhesive tape.

As for the crystallinity of the formed single crystal thin films, the half width of the rocking curve of the X ray diffraction line from the lattice plane of a Miller Index (002) was not more than 100 seconds altogether.

In the other, the bulk-like gallium nitride single crystal with a 10 mm×10 mm×thickness of 0.5 mm marketed was prepared as a substrate.

The crystal C axis of this bulk gallium nitride single crystal is a perpendicular direction to a substrate surface, and the surface is ground to the mirror surface.

The bulk-like aluminum nitride single crystal with a 3 mm×3 mm×thickness of 0.5 mm independently produced by the sublimating method was prepared as a substrate.

The crystal C axis of this bulk aluminum nitride single crystal is a perpendicular direction to a substrate surface, and the surface is ground to the mirror surface.

In the bulk single crystal which comprises a gallium nitride as the main ingredients and the bulk single crystal which comprises an aluminum nitride as the main ingredients, the content of impurities was few, it was what consists of GaN and AlN substantially, respectively.

Thus, the refractive index in the wavelength 650 nm of the thin film formed on the prepared above-mentioned thin film substrate and a bulk single crystal substrate was measured using the spectrophotometer (Spectrophotometer) “product name: FilmTek4000” made from U.S. “SCI (Scientific Computing International) Co.”.

Next, to these thin film substrates and a bulk single crystal substrate, various thin films were formed all over the substrate in the thickness of 50 nm with the substrate temperature of 250 degrees C. by using the target which consists of each material of metal gallium, a gallium nitride, gallium oxied, metal indium, an indium nitride, indium oxide, metal niobium, niobium nitride, niobium oxide, metal tantalum, tantalum nitride, and tantalum oxide by the RF magnetron sputtering method of the frequency of 13.5 MHz and electric power of 800 W.

As the gas for sputtering, pure Ar and the mixed gas of N₂+Ar of the range of the mixture ratio N₂/Ar=0.02-0.80 was introduced, and it was used in the condition where the pressure inside the chamber was 0.9 Pa.

Pure Ar was used in each thin film formation of gallium oxide, indium oxide, niobium oxide, tantalum oxide, metal niobium, and metal tantalum.

When forming each thin film of a gallium nitride, an indium nitride, niobium nitride, and tantalum nitride, it used changing the mixed gas composition ratio of N₂+Ar suitably.

The target which consists of metal gallium and metal indium was used for formation of the gallium nitride and an indium nitride thin film by reaction sputtering, respectively.

Thus, patterning of the obtained sputtering thin film was carried out so that it might remain as a line of a size with a width of 10 μm×thickness of 50 nm using the lift-off method by optical lithography.

Patterning was carried out so that another portion of this sputtering thin film might remain as a line which is the width of 1.5 mm×thickness of 50 nm using the same sputtering thin film.

As for the length of this sputtering thin film in which patterning was carried out, it is 25.4 mm in the case of what used the substrate which comprises an aluminum nitride as the main ingredients, it is 10 mm in the case of what used a bulk-like gallium nitride single crystal, it is 3 mm in the case of what used a bulk-like aluminum nitride single crystal.

Next, it heated at 1500 degrees C. among nitrogen atmosphere for 6 hours.

Although the appearance after heating was investigated, faults, such as exfoliation between each thin film and the sintered compacts which comprise an aluminum nitride as the main ingredients, were not seen.

Although the appearance of the portion of each thin film in which each ingredient of gallium, indium, niobium, and tantalum was formed was observed, neither a crack nor exfoliation was seen.

And, although the exfoliation test was performed using pressure sensitive adhesive tape, there were no exfoliation between the thin film formed and the sintered compacts which comprise an aluminum nitride as the main ingredients, and no exfoliation and destruction of the thin film portion in which each ingredient of gallium, indium, niobium, and tantalum was formed.

Also as for each bulk single crystal after heating, the fault on appearance, such as a crack in the portion in which each ingredient of gallium, indium, niobium, and tantalum was formed, was not seen.

Next, the refractive index of a portion which gave patterning with a width of 1.5 mm among the portions in which the sputtering thin film that consists of each ingredient of gallium, indium, niobium, and tantalum was formed was measured by the light with a wavelength 650 nm using each sample of the thin film substrate and bulk single crystal substrate after heating.

refractive index measurement was carried out using the spectrophotometer (Spectrophotometer) “product name: FilmTek4000” made from U.S. “SCI (Scientific Computing International) Co.”.

Consequently, it was confirmed that the refractive index of the thin film and a bulk single crystal which carried out stress relief heat treatment after sputtering thin film formation which has the ingredient of gallium, indium, niobium, and tantalum becomes large than the refractive index of the first produced thin film which comprises as the main ingredients at least one or more materials selected from a gallium nitride, an indium nitride, and an aluminum nitride, and the bulk single crystal.

As this result, it is predicted that the ingredient of gallium, indium, niobium, and tantalum is diffusing and dissolving into the first produced thin film which comprises as the main ingredients at least one or more materials selected from a gallium nitride, an indium nitride, and an aluminum nitride, and the bulk single crystal.

In all samples, the amount of increases of a refractive index was in the range of 0.002-0.012, and was not more than 2×10⁻¹.

Therefore, as for the increasing amount of the ingredient of gallium, and indium, and the introducing amount of the ingredient of niobium, and tantalum in the first produced thin film which comprises as the main ingredients at least one or more materials selected from a gallium nitride, an indium nitride, and an aluminum nitride, and the bulk single crystal, it seems that it is at least not more than 20 mol %, and it is the range of 0.1 mol %-5.0 mol % to the main ingredients by gallium nitride, indium nitride, niobium nitride, and tantalum nitride conversion, respectively.

The domain where the gallium ingredient, the indium ingredient, the niobium ingredient, and the tantalum ingredient were introduced to the thin film and bulk single crystal after heating spreads in width of 12 μm-18 Am, and it seems in the depth direction that it amounts to 0.5 μm-10 μm by measurement by the above-mentioned spectrophotometer “FilmTek4000”.

Thus, the thin film substrate in which each ingredient of gallium, indium, niobium, and tantalum was introduced in the shape of belt-like into the thin film which comprises as the main ingredients at least one or more materials selected from a gallium nitride, an indium nitride, and an aluminum nitride and which was formed on the substrate which consists of a sintered compact which comprises an aluminum nitride as the main ingredients was obtained.

And, bulk single crystal substrate in which each ingredient of gallium, indium, niobium, and tantalum was introduced in the shape of belt-like into the bulk single crystal which comprises a gallium nitride as the main ingredients and the bulk single crystal which comprises an aluminum nitride as the main ingredients, respectively.

Next, by using the above-mentioned sputtering thin film, into the portion into which the ingredient of gallium, indium, niobium, and tantalum was introduced to the thin film which comprises as the main ingredients at least one or more materials selected from a gallium nitride, an indium nitride, and an aluminum nitride and into the portion which gave patterning with a width of 10 μm to the sputtering thin film before heat treatment among the portions into which the ingredient of gallium, indium, niobium, and tantalum was introduced into the bulk single crystal, the red light is inputted with 50 mW of outputs using the commercial red semiconductor laser of a GaAsP system with a luminescence wavelength 650 nm, then the transmission loss was computed by having measured the amount of attenuation of the output light transmitted.

Consequently, it was not based on the quality of the material of a substrate, and composition, but was penetrable to 650 nm red light in all samples, and transmission loss was also not more than 10 dB/cm in all samples.

When thin films are a single crystal, the transmission losses were not more than 5 dB/cm altogether.

Transmission losses of the single crystal thin films which were formed by using experiment No.269 as a substrate which consists of a sintered compact which comprises an aluminum nitride as the main ingredients were not more than 3 dB/cm altogether.

Transmission losses of the single crystal thin films which include an aluminum nitride not less than 80 mol % were not more than 1 dB/cm altogether.

Also in the bulk single crystal which comprises an aluminum nitride as the main ingredients, transmission losses were not more than 1 dB/cm in all samples.

Consequently, it was confirmed that the portion in which the ingredient of gallium, indium, niobium, and tantalum was mixed into the thin film which comprises as the main ingredients at least one or more materials selected from a gallium nitride, an indium nitride, and an aluminum nitride and the bulk single crystal which were produced in this Example functions as an embedding type three dimension optical waveguide.

These results were shown in Table 27.

The value of the transmission loss measured using light with a wavelength 650 nm is shown in Table 27.

Next, after confirming optical transmission by the above-mentioned red light, the transmission loss in the ultraviolet light domain of the above-mentioned each three dimension optical waveguide produced in this Example was measured further by using the wavelength variable laser light generating equipment of commercial item.

Measurement wavelength is four kinds of 380 nm, 300 nm, 270 nm, and 250 mn.

Consequently, it was confirmed that there is high transmission nature to ultraviolet light in a thin film with many aluminum nitride contents among the thin film formed on the substrate which consists of a sintered compact which comprises an aluminum nitride as the main ingredients and the bulk single crystal which comprises an aluminum nitride as the main ingredients.

Compared with a thin film with many gallium nitride contents and the bulk single crystal which comprises a gallium nitride as the main ingredients not showing transmission nature to the light with wavelength shorter than 380 nm, the most thin film with many aluminum nitride contents and the bulk single crystal which comprises an aluminum nitride as the main ingredients showed the high transmission nature to ultraviolet light.

That is, in the thin film formed on-the substrate which consists of a sintered compact which comprises an aluminum nitride as the main ingredients, thin film which includes an aluminum nitride not less than 50 mol % can transmit the ultraviolet light up to the wavelength 300 nm at least, the transmission loss was not more than 10 dB/cm.

And, in the thin film formed on the substrate which consists of a sintered compact which comprises an aluminum nitride as the main ingredients, thin film which includes an aluminum nitride not less than 90 mol % can transmit the ultraviolet light up to the wavelength 270 nm at least, the transmission loss was not more than 10 dB/cm.

And, in the thin film of 2 ingredient composition which comprises an aluminum nitride as the main ingredients and contains a gallium nitride further among the thin film formed on the substrate which consists of a sintered compact which comprises an aluminum nitride as the main ingredients, what includes an aluminum nitride not less than 50 mol % can transmit the ultraviolet light up to the wavelength 300 nm at least, the transmission loss was not more than 10 dB/cm.

And, when the above-mentioned thin film is a single crystal, transmission loss is at least not more than 5 dB/cm, in the case of the optical waveguide formed in the single crystal thin film substrate which includes an aluminum nitride 50 mol % and was produced in experiment No.590 of this Example, it was 2.4 dB/cm and was not more than 3 dB/cm.

And, what includes an aluminum nitride not less than 80 mol % can transmit the ultraviolet light up to the wavelength 270 nm at least, the transmission loss was not more than 10 dB/cm.

And, when the above-mentioned thin film is a single crystal, transmission loss is at least not more than 5 dB/cm, in the case of the single crystal thin film substrate which includes an aluminum nitride 80 mol % and was produced in experiment No.589 of this Example, transmission loss of light with a wavelength 270 nm was 0.9dB/cm and was not more than 3 dB/cm.

And, what includes an aluminum nitride not less than 90 mol % can transmit the ultraviolet light up to the wavelength 250 nm at least, the transmission loss was not more than 10 dB/cm.

And, when the above-mentioned thin film is a single crystal, transmission loss is at least not more than 5 dB/cm, also in the case of the single crystal thin film substrate which includes an aluminum nitride 90 mol % and was produced in experiment No.588 and experiment No.601 in this Example, transmission loss of light with a wavelength 250 nm was 2.5 dB/cm, 2.6 dB/cm, respectively and was not more than 3 dB/cm.

Thus, as for the thin film substrate in which an optical waveguide consists of the thin film which comprises as the main ingredients at least one or more materials selected from a gallium nitride, an indium nitride, and an aluminum nitride and which was formed on the sintered compact according to this invention which comprises an aluminum nitride as the main ingredients, it was confirmed that it has high transmission nature to the ultraviolet light.

And, it was confirmed that the thing which contains at least one or more ingredients selected from niobium and tantalum, in the thin film or bulk single crystal which comprise as the main ingredients at least one or more materials selected from a gallium nitride, an indium nitride, and an aluminum nitride, etc. can be used as an optical waveguide.

And, it was simultaneously confirmed that the bulk single crystal which comprises as the main ingredients at least one or more materials selected from a gallium nitride, and an aluminum nitride can be used as an optical waveguide.

It was confirmed that the bulk single crystal which comprises an aluminum nitride as the main ingredients in it can transmit the ultraviolet light.

These results were shown in Table 28.

The value of the transmission loss measured using light of the wavelength 380 nm, 300 nm, 270 nm, and 250 nm is shown in Table 28.

### COMPARATIVE EXAMPLE

The sapphire substrate of commercial item which has the lattice plane of a Miller Index (002) was prepared.

To this sapphire substrate, specular surface polish has been carried out in average surface roughness Ra 1.2 nm.

Some sapphire substrates are in the got surface state as it is, and formed the 100 mol % AlN orientated polycrystalline thin film on some sapphire substrates on the same conditions as this Example.

A 100 mol % AlN single crystal thin film was formed on these substrates by the same MOCVD method as this Example after that, then the thin film of a gallium oxide was formed on it by an RF sputtering method, patterning of this sputtering thin film was carried out to the line of a size with a width of 10 μm×thickness of 50 nm using the lift off method by optical lithography, it heat-treated at 1500 degrees C. in nitrogen atmosphere, and the optical waveguide was produced.

Next, although transmission loss of this optical waveguide was measured by the same method as this Example, it was larger than 10 dB/cm in all the cases of the wavelength 650 nm, 380 nm, 300 nm, 270 nm, and 250 nm.

### EXAMPLE 23

What processed the sintered compact which comprises an aluminum nitride as the main ingredients indicated in experiment No.49 produced in Example 11 like Example 22 in the shape of a substrate of a size with a diameter of 25.4 mm×thickness of 0.5 mm, and carried out specular surface polish further was prepared.

Next, the thin film substrate which formed the single crystal thin film which consists of 100 mol % of aluminum nitride substantially in the thickness of 25 μm by the same MOCVD method as having used in Example 22 was produced.

The refractive index to the light with a wavelength 605 nm of the single crystal thin film formed on this thin film substrate was 2.19017.

Next, in room temperature, by magnetron sputtering, each thin, film of a gallium nitride, an indium nitride, niobium nitride, and tantalum nitride was formed to the above-mentioned thin film substrate all over the substrate like Example 22 changing thickness in 1.0 nm-1000 nm.

Thus, patterning of the obtained sputtering thin film was carried out so that it might remain as a line of a size with a width of 10 μm×length of 25.4 mm using the lift off method by optical lithography.

Patterning was carried out so that another portion of this sputtering thin film might remain as a line with a width of 1.5 mm×length of 25.4 mm using the same sputtering thin film.

It heated at 1500 degrees C. in nitrogen atmosphere for 6 hours after that.

Although the appearance after heating was investigated, faults, such as exfoliation between each thin film and the sintered compacts which comprise an aluminum nitride as the main ingredients, were not seen.

Although the appearance of the portion in which each ingredient of gallium, indium, niobium, and tantalum was formed in each thin film was observed, neither-a crack nor exfoliation was seen.

And, although the exfoliation test was performed using pressure sensitive adhesive tape, there were no exfoliation between the formed thin film and the sintered compacts which comprise an aluminum nitride as the main ingredients, and no exfoliation and destruction of the thin film portion in which each ingredient of gallium, indium, niobium, and tantalum was formed.

Next, the refractive index of a portion which gave patterning with a width of 1.5 mm×length of 25.4 mm among the portions in which the sputtering thin film that consists of each ingredient of gallium, indium, niobium, and tantalum was formed was measured by the light with a wavelength 650 nm using each sample of the thin film substrate after heating by the same spectrophotometer as what was used in Example 21 and Example 22.

Consequently, it was confirmed that the refractive index of the thin film which carried out stress relief heat treatment after forming the sputtering thin film which has the ingredient of gallium, indium, niobium, and tantalum becomes large than the refractive index of the aluminum nitride single crystal thin film which was produced first and consists of composition of 100 mol % substantially.

It was also confirmed that a refractive index becomes large as the formation thickness of each sputtering material of gallium, indium, niobium, and tantalum became thick.

It seems that this result will have suggested that whose ingredient of gallium, indium, niobium, and tantalum is difflused, and is introduced in the aluminum nitride single crystal thin film which was produced first and which consists of 100-mol % of composition substantially and composition is changed, if it considers by referring the thin film composition investigated in Example 21, and change of the refractive index accompanying it.

The range of the amount of change of a refractive index is 4×10⁻⁵ to 8.4×10⁻² in the sample in which a gallium ingredient was diff-used and introduced, and it seems that the content of a gallium ingredient is in the range of 0.01 mol %-40 mol % by gallium nitride conversion.

And, the range of the amount of change of a refractive index is 6×10⁻⁵ to 9.4×10⁻² in the sample in which a indium ingredient was difflused and introduced, and it seems that the content of a indium ingredient is in the range of 0.01 mol %-20 mol % by indium nitride conversion.

And, the range of the amount of change of a refractive index is 9×10⁻⁵ to 1.1×10⁻¹ in the sample in which a niobium ingredient was difflused and introduced, and it seems that the content of a niobium ingredient is in the range of 0.01 mol %-20 mol % by niobium nitride conversion.

And, the range of the amount of change of a refractive index is 7×10⁻⁵ to 1.1×10⁻¹ in the sample in which a tantalum ingredient was difflused and introduced, and it seems that the content of a tantalum ingredient is in the range of 0.01 mol %-20 mol % by tantalum nitride conversion.

Thus, in all samples, the amount of increases of a refractive index is in the range of 1×10⁻⁵ to 2×10⁻¹, it seems that the ingredient which consists of at least one or more elements selected from gallium, indium, niobium, and tantalum is introduced in the above-mentioned quantity to the inside of the aluminum nitride single crystal thin film which was produced first and consists of composition of 100 mol % substantially.

Next, by using the wavelength variable laser light generating equipment of commercial item, light with the wavelength 650 nm, 380 nm, 300 ni, and 250 nm was inputted into the portion which gave patterning with a width of 10 μm×length of 25.4 mm to this sputtering thin film before heat treatment among the above-mentioned portion in which the ingredient of gallium, indium, niobium, and tantalum was mixed in the single crystal thin film which comprises an aluminum nitride as the main ingredients by the sputtering thin film, transmission loss was computed after having measured the amount of attenuation of a transmitted output light.

As a result, it was penetrable to incidence light in all samples, and transmission loss was also not more than 3 dB/cm in all samples.

Consequently, it was confirmed that the portion which was produced in this Example and whose ingredient of gallium, indium, niobium, and tantalum was mixed to the aluminum nitride single crystal thin film which consists of composition of 100 mol % substantially functions as three dimension optical waveguide of an embedding type which can transmit ultraviolet light and visible light.

These results were shown in Table 29.

### EXAMPLE 24

The substrate which consists of a sintered compact of experiment No.49, experiment No.58, and experiment No.269 which comprises an aluminum nitride as the main ingredients and was used in Example 21 and Example 22 was prepared.

To all these substrates, the orientated polycrystalline thin film which consists of an aluminum nitride of 100 mol % composition substantially was formed in thickness of 6 μm by the RF sputtering method with the condition where substrate temperature was 280 degrees C., an aluminum nitride sintered compact was used as a target, the frequency was 13.56 MHz, electric power was 1000 W.

C axis of this orientated polycrystalline thin film was formed in perpendicular direction to the substrate surface, and the half width of the rocking curve of the X ray diffraction line from the lattice plane of a Miller Index (002) was in the range of 6360 seconds-7150 seconds. The refractive index was 1.937-1.973.

Next, the thin film substrate on which the single crystal thin film of various compositions which comprises as the main ingredients at least one or more materials selected from a gallium nitride, an indium nitride, and an aluminum nitride and contains the ingredient of niobium and tantalum suitably was formed in the thickness of 2 μm on this orientated polycrystalline thin film by the same MOCVD method as Example 21 was produced.

The single crystal thin film was formed so that the crystal C axis might become perpendicular to a substrate surface.

The above-mentioned polycrystalline thin film was not formed on the substrate which consists of a sintered compact which comprises an aluminum nitride as the main ingredients used in experiment No.669-673, but the single crystal thin film by direct MOCVD was formed directly on this sintered compact.

Although this appearance after single crystal thin film formation was investigated, faults, such as exfoliation between each orientated polycrystalline thin film and a single crystal thin film, and the sintered compacts which comprise an aluminum nitride as the main ingredients, were not seen.

Faults, such as exfoliation between each polycrystalline thin film and a single crystal thin film, were not seen.

Although the exfoliation test was performed using pressure sensitive adhesive tape, there were not exfoliation between each polycrystalline thin film and a single crystal thin film, and the sintered compacts which comprise an aluminum nitride as the main ingredients, and the exfoliation or destruction between each polycrystalline thin film and a single crystal thin film.

Thus, all the refractive indices of the obtained above-mentioned single crystal thin film were not less than 2.16, and were almost the same as the value which did not depend on the difference of the substrate which consists of a sintered compact which comprises an aluminum nitride as the main ingredients, but was measured in Example 21-23 in what is the same composition as

### EXAMPLE 21

The produced thin film substrate has the form in which the formed single crystal thin film may function as a two dimensional optical waveguide as shown in FIG. 21 and FIG. 23.

Next, dry type etching only of the single crystal thin film portion was carried out by ion milling using a part of produced thin film substrate, and it was processed with a width of 10 μm in the shape of a straight line.

This thin film substrate has the form in which the single crystal thin film obtained by processing may function as a three dimension waveguide way as shown in FIG. 24 and FIG. 25.

Next, light with the wavelength 650 nm, 300 nm, and 250 nm was inputted into the portion of a two dimensional optical waveguide and a three dimensional optical waveguide of a thin film substrate which were produced as mentioned above by using wavelength variable laser light generating equipment of commercial item, transmission loss was computed after having measured the amount of attenuation of a transmitted output light.

As a result, it was penetrable to incidence light in all samples, and transmission loss was also not more than 10 dB/cm in all samples.

Consequently, it was confirmed that the portion in which the ingredient of gallium, indium, niobium, and tantalum was mixed into the aluminum nitride single crystal thin film which was produced in this Example and which consists of the composition of 100-mol % substantially functions as a two dimensional optical waveguide and a three dimension optical waveguide which are able to transmit ultraviolet light and visible light.

The characteristic as an optical waveguide does not depend on the difference of the substrate which consists of a sintered compact which comprises an aluminum nitride as the main ingredients.

Even if it was the single crystal thin film which was formed directly on the sintered compact which comprises an aluminum nitride as the main ingredients, it was confirmed that it functions enough as an optical waveguide which can transmit ultraviolet light and visible light.

These results were shown in Table 30.

### EXAMPLE 25

This Example shows the example of the multilayer thin film in which the single crystal thin film which comprises as the main ingredients at least one or more materials selected from a gallium nitride, an indium nitride, and an aluminum nitride was formed furthermore on these thin films after forming beforehand a single crystal thin film, an amorphous thin film, a polycrystalline thin film, and an orientated polycrystalline thin film which comprise as the main ingredients at least one or more materials selected from a gallium nitride, an indium nitride, and an aluminum nitride on it using the sintered compact which comprises an aluminum nitride as the main ingredients as a substrate by the method of not only a MOCVD but also a sputtering and an ion-plating method. Among these, this Example also shows the effect whose thin film which forms beforehand on the substrate which comprises an aluminum nitride as the main ingredients gives to the crystallinity of the single crystal thin film which forms further on it.

In addition, the sintered compact which comprises an aluminum nitride as the main ingredients and was used as a substrate includes also what has a conduction via.

As a sintered compact which comprises an aluminum nitride as the main ingredients, the thing which contained the sintering-aids ingredient and had comparatively many contents of an AlN ingredient was used.

First, as what does not have a conduction via among the sintered compacts which comprise an aluminum nitride as the main ingredients, the thing which was produced in experiment No.49, and 59 of Example 2 and experiment No.259, 261, 266, and 269 of Example 11 and carried out ultrasonic washing by acetone and IPA after immersing in room temperature into fluoro-nitric acid (50% HF+50% HNO₃) after carrying out mirror polishing of the surface by the same method as Example 8 was prepared as a substrate.

As for surface roughness of a substrate without these conduction vias, it was Ra 26 nm in the case of experiment No.49, Ra 28 nm in the case of experiment No.58, and Ra 30 nm in the case of experiment No.259, 261, 266, and 269.

Next, as what has a conduction via, the thing which was produced in experiment No. 80, and 83 of Example 3 and experiment No.304 of Example 14 and which carried out mirror polishing of the surface by the same method as Example 8 and was washed with methylene chloride was prepared as a substrate.

Surface roughness was Ra 26 nm in the case of experiment No.80 and experiment No.83, and was Ra 30 nm in the case of experiment No.304.

As what has a conduction via, using what contains Er₂O₃ powder 4.02 volume % among the green sheets produced in Example 3, the through hole of 50 μm was punched in this green sheet, and it was filled up with what contains AlN 5.0 weight % among the conduction via paste which comprises tungsten as the main ingredients and was produced in Example 14, normal pressure sintering was carried out for 2 hours at 1820 degrees C. like Example 3, it made the same size as Example 3 by grinding, and polishing to mirror surface and a conduction via was exposed, what was washed with methylene chloride was prepared as a substrate.

The surface roughness of a substrate which has this conduction via was Ra 32 nm.

First, the thin film which comprises as the main ingredients at least one or more materials selected from a gallium nitride, an indium nitride, and an aluminum nitride and which is various crystallized states, such as a single crystal thin film, an amorphous thin film, a polycrystalline thin film, and an orientated polycrystalline thin film, was formed on each substrate prepared as mentioned above by the MOCVD method, the sputtering method, and the ion-plating method.

When thin film formation was performed by the MOCVD method, the same raw material and conditions of thin film formation as Example 1, Example 10, Example 12, and Example 17 were used.

When thin film formation is performed by the sputtering method, by the high frequency (RF) magnetron sputtering method with a frequency of 13.56 MHz using metal aluminum, an AlN sintered compact, and the AlN sintered compact which contains 0.02-mol % Si ingredient as a target, examination of thin film formation was performed under the condition where the mixed gas of Ar+N₂ of very small quantity was introduced with the mixture ratio of N₂/Ar=0.02-1.0, the pressure inside the chamber was 0.1-1.5 Pa, and electric power was 400-1500 W.

Substrate temperature was performed in the range of room temperature −600 degrees C.

On the other hand, when thin film formation is performed by the ion-plating method, metal aluminum was used for the raw material for thin film formation, and aluminum metal was fused, very-small-quantity N₂ gas was introduced in a decompression chamber, and it ionized on the ionization voltage 20V-150V, examination of thin film formation was performed by carrying out the reaction nitriding of the metal vapor with the applied voltage of 500V-2000V to the substrate.

Substrate temperature was performed in the range of room temperature −600 degrees C.

The crystallized state was investigated by X ray diffraction about the thin film which was directly formed on the substrate which consists of a sintered compact which comprises an aluminum nitride as the main ingredients as mentioned above, and as for the thin film produced, the half width of the rocking curve of the lattice plane of a Miller Index (002) and electric resistivity in room temperature was measured further.

The result is shown in Table 31 and Table 32, 33, and 34.

Next, onto the substrate which consists of a sintered compact which comprises an aluminum nitride as the main ingredients and formed the thin film of the above-mentioned various crystallized state, formation of the single crystal thin film which comprises as the main ingredients at least one or more materials selected from a gallium nitride, an indium nitride, and an aluminum nitride was tried by the MOCVD method using the same raw material and the thin film formation condition as what was shown in Example 1, Example 2, and Example 10 and the Chloride VPE method using the same raw material and the thin film formation condition as what was shown in Example 9.

The crystallized state was investigated by X ray diffraction about each formed single crystal thin film, and as for the thin film produced, the half width of the rocking curve of the lattice plane of a Miller Index (002) and the electric resistivity in room temperature was measured further.

This result was also shown in Table 31 and Table 32, 33, and 34.

Table 31 and 32 is an experimental result about the thin film which does not contain a doping ingredient, and Table 33 and 34 is an experimental result about the thin film containing a doping ingredient.

The characteristic of the AlN thin film formed directly on the substrate which consists of a sintered compact which comprises an aluminum nitride as the main ingredients in the thickness of 3 μm is shown in experiment No.706-709 of Table 31.

The thin film of experiment No.706 is what was produced by the sputtering method under the condition of which the substrate temperature was made into room temperature, the mixed gas of Ar+N₂ was introduced with the mixture ratio of N₂/Ar=0.6, the pressure inside the chamber was 0.5 Pa, and electric power was 500 W.

The thin film of experiment No.707 is what was produced by the sputtering method under the condition of which the substrate temperature was made into 250 degrees C., the mixed gas of Ar+N₂ was introduced with the mixture ratio of N₂/Ar=0.3, the pressure inside the chamber was 0.6 Pa, and electric power was 800 W.

The thin film of experiment No.708 is what was produced by the sputtering method under the condition of which the substrate temperature was made into 280 degrees C., the mixed gas of Ar+N₂ was introduced with the mixture ratio of N₂/Ar=0.4, the pressure inside the chamber was 0.8 Pa, and electric power was 1000 W.

The high purity AlN sintered compact was used for the target in sputtering of experiment No.706-708.

The thin film of experiment No.709 uses trimethyl aluminum as a raw material, and produces it by the MOCVD method of the same conditions as Example 1.

Although the crystallinity judgment of these thin films was performed by X ray diffraction, as described in Table 31, it was amorphous in the case of experiment No.706, it was polycrystal in the case of experiment No.707, it was orientated polycrystal in the case of experiment No.708, and it was single crystal in the case of experiment No.709, respectively, as the crystallized state.

As for the polycrystal of experiment No.707, the diffraction line appeared only from the lattice plane of a Miller Index (002), (101), (102).

In all thin films which were produced in experiment No.708 and 709, C axis was formed in the perpendicular direction to the substrate surface.

The half width of the rocking curve of the X ray diffraction line from the lattice plane of the Miller Index (002) of the thin film of experiment No.708 and 709 was 7910 seconds and 187 seconds, respectively, and even if the growth direction of a crystal of the orientated polycrystalline thin film and the single crystal thin film was the same, the difference was clearly looked at by crystallinity.

The appearance of the above-mentioned thin film produced by experiment No.706-709 was investigated, and, in all, defects, such as a crack and a crevice, are not seen.

Although the exfoliation test by pressure sensitive adhesive tape was performed, exfoliation was not seen between the substrates which consist of a sintered compact which comprises an aluminum nitride as the main ingredients in all the thin films.

Although the thin film conductivity material of Ti/Pt/Au was formed on the surface of the thin film produced in experiment No.706-709, the metal lead was soldered and perpendicular tensile strength was investigated, it all is not less than 2 Kg/mm², so it has joined firmly between the sintered compact which comprises an aluminum nitride as the main ingredients and each above-mentioned thin film.

In experiment No.710-713 of Table 31, the characteristic of an AlN thin film being formed furthermore on it in the thickness of 3 μm, respectively, by the MOCVD method of same conditions as above-mentioned experiment No.709 of this Example is shown, by using the substrate on which the AlN amorphous thin film, the AlN polycrystalline thin film, and the AlN orientated polycrystalline thin film which were produced by the sputtering method of the same conditions as experiment No.706, 707, and 708, were formed in the thickness of 3 μm respectively, and the substrate on which the single crystal thin film with a thickness of 3 μm was formed beforehand and which was produced in experiment No.709.

These thin films are the single crystals clearly formed in the direction where C axis is perpendicular to the substrate surface as a result of X ray diffraction.

As for the crystallinity of the single crystal thin film which comprises AlN as the main ingredients and was produced in experiment No.710, 711, 712, and 713, the half width of the rocking curve of the X ray diffraction line from the lattice plane of a Miller Index (002) is 89 seconds, 93 seconds, 79 seconds, and 105 seconds, respectively, clearly it is superior to 187 seconds of the AlN single crystal thin film of experiment No.709 produced by the MOCVD method of the same conditions.

Thus, the single crystal thin film which comprises an aluminum nitride as the main ingredients can be formed on it by using the substrate which consists of a sintered compact which comprises an aluminum nitride as the main ingredients and which formed beforehand the AlN thin film of an amorphous thin film, a polycrystalline thin film, an orientated polycrystalline thin film, and a single crystal thin film, it was confirmed that the crystallinity improves than the single crystal thin film formed directly on the substrate which consists of a sintered compact which comprises an aluminum nitride as the main ingredients.

In experiment No.710-712, when the substrate on which the thin film which is formed beforehand on the substrate is an amorphous state, a polycrystal, and an orientated polycrystal is used, it is shown that the half width of the rocking curve of the X ray diffraction line from the lattice plane of the Miller Index (002) of the AlN single crystal thin film formed on it is not more than 100 seconds, the crystallinity of the AlN single crystal thin film formed on it was superior to the substrate whose thin film formed beforehand on a substrate as shown in experiment No.713 is a single crystal.

The appearance of the above-mentioned thin film produced in experiment No.710-713 was investigated, and, in all, defects, such as a crack and a crevice, are not seen.

Although the exfoliation test by pressure sensitive adhesive tape was performed, in all the thin films, exfoliation was not seen between the substrates which consist of a sintered compact which comprises an aluminum nitride as the main ingredients, or between thin films.

Although the thin film conductivity material of Ti/Pt/Au was formed on the surface of the thin film produced in experiment No.710-713, the metal lead was soldered and perpendicular tensile strength was investigated, it all is not less than 2 Kg/mm², so it has joined firmly between the sintered compact which comprises an aluminum nitride as the main ingredients and each above-mentioned thin film, or between each thin film.

The characteristic of the GaN thin film and an InN thin film formed directly on the substrate which consists of a sintered compact which comprises an aluminum nitride as the main ingredients in the thickness of 3 μm, is shown in experiment No.714-715 of Table 31.

These thin films are produced by the MOCVD method of the same conditions as Example 1 by using trimethyl gallium and trimethyl indium as a raw material.

As for these obtained thin films, it was confirmed that these are a single crystal of which C axis was clearly formed in the perpendicular direction to the substrate surface in all by X ray diffraction.

As for the half width of the rocking curve of the X ray diffraction line from the lattice plane of the Miller Index (002) of these single crystal thin film, it was 179 seconds in the case of GaN, and was 190 seconds in the case of InN, respectively, as GaN and InN.

In experiment No.716 and 717, the characteristic of GaN and InN each thin film which was formed furthermore in the thickness of 3 μm by the MOCVD method of the same conditions as this above-mentioned Example on it, by using the substrate on which the AlN orientated polycrystalline thin film produced on the same sputtering conditions as experiment No.708 was formed in the thickness of 3 μm, is shown.

Each thin film of these GaN and InN is the single crystal clearly formed in the direction where C axis is perpendicular to the substrate surface as a result of X ray diffraction.

The half width of the rocking curve of the X ray diffraction line from the lattice plane of the Miller Index (002) of these single crystal thin films which comprise GaN and InN as the main ingredients and are formed beforehand on the substrate which formed the orientated polycrystalline thin film is 89 seconds and 87 seconds, respectively, so it is not more than 100 seconds, it was clearly superior to 179 seconds of the GaN single crystal thin film of experiment No.714 and 190 seconds of the InN single crystal thin film of experiment No.715, which were produced by the MOCVD method of the same conditions.

In Experiment No.718, 719, and 720, the characteristic of the GaN thin film which was formed furthermore on it in the thickness of 3 μm by the MOCVD method of the same conditions as this above-mentioned Example by using the substrate which formed beforehand an AlN amorphous thin film, a polycrystalline thin film, and a single crystal thin film in the thickness of 3 μm and which were produced on the same conditions as experiment No.706, 707, and 709, respectively, is shown.

These GaN thin films are the single crystals clearly formed in the direction where C axis is perpendicular to the substrate surface.

The half width of the rocking curve of the X ray diffraction line from the lattice plane of the Miller Index (002) of these single crystal thin films which comprise GaN as the main ingredients and which are formed on the substrates which formed beforehand the orientated polycrystalline thin film is 90 seconds, 92 seconds, and 107 seconds, respectively, it was clearly superior to 179 seconds of the GaN single crystal thin film of experiment No.714 produced by the MOCVD method of the same conditions.

As shown in experiment No.716, and 718 and 719, when the substrate on which the thin film which is formed beforehand on the substrate is an amorphous state, a polycrystal, and an orientated polycrystal is used, the half width of the rocking curve of the X ray diffraction line from the lattice plane of the Miller Index (002) of the GaN single crystal thin film formed on it is not more than 100 seconds, the crystallinity of the GaN single crystal thin film formed on it was superior to the substrate whose thin film formed beforehand on a substrate as shown in experiment No.720 is a single crystal.

Thus, also not only in the single crystal thin film which comprises AlN as the main ingredients but also in the single crystal thin film which comprises GaN and InN as the main ingredients, it was confirmed that if it forms on it by using the substrate which formed beforehand the orientated polycrystalline thin film, the single crystal thin film which is more excellent in crystallinity than forming directly on the substrate which consists of a sintered compact which comprises an aluminum nitride as the main ingredients is producible.

Although the appearance of the above-mentioned thin film produced in experiment No.714-715 was investigated, defects, such as a crack and a crevice, are not seen.

Although the exfoliation test by pressure sensitive adhesive tape was performed, exfoliation was not seen between the substrates which consist of a sintered compact which comprises an aluminum nitride as the main ingredients.

The appearance of the above-mentioned thin film produced in experiment No.716-720 was investigated, and, in all, defects, such as a crack and a crevice, are not seen.

Although the exfoliation test by pressure sensitive adhesive tape was performed, in all the thin films, exfoliation was not seen between the substrates which consist of a sintered compact which comprises an aluminum nitride as the main ingredients, or between thin films.

Although the thin film conductivity material of Ti/Pt/Au was formed on the surface of the thin film produced in experiment No.714-720, the metal lead was soldered and perpendicular tensile strength was investigated, it all is not less than 2 Kg/mm², so it has joined firmly between the sintered compact which comprises an aluminum nitride as the main ingredients and each above-mentioned thin film, or between each thin film.

In experiment No.721 and 722 of Table 31, the characteristic of the 100 mol % AlN thin film directly formed on the substrate which consists of a sintered compact which comprises an aluminum nitride as the main ingredients in the thickness of 3 μm is shown.

This thin film is formed by the MOCVD method and the ion-plating method.

The AlN thin film shown in experiment No.721 is produced from the same raw material and by the same conditions of thin film formation as Example 1 and Example 12, except having made substrate temperature into 480 degrees C. by the MOCVD method.

The AlN thin film shown in experiment No.722 is what was produced by the ion-plating method on the condition where the substrate temperature was 250 degrees C., metal aluminum was used for a raw material, N₂ gas was flowing 40 cc/min. as a rate, an ionization voltage was 40 volts, and a substrate applied voltage was 1000 volts.

The thing of experiment No.721 is the orientated polycrystal of which C axis was formed in the perpendicular direction to the substrate surface among the obtained AlN thin films, and the half width of the rocking curve of the X ray diffraction line from the,lattice plane of a Miller Index (002) was 4670 seconds, the crystallinity was superior to the thin film by the sputtering method. The thing of experiment N0.722 was a polycrystal whose diffraction peak from the Miller Index (100), (002) appeared.

In experiment No.723 and 724, the characteristic of the AlN thin film formed furthermore in the thickness of 3 μm by the MOCVD method of the same conditions as Example 1 on it, respectively by using the substrate in which the AlN orientated polycrystalline thin film and the AlN polycrystalline thin film were formed beforehand in of the same conditions as the above-mentioned MOCVD method and ion-plating method is shown

As a result of X ray diffraction, these thin films formed after are clearly the single crystal formed in the direction where C axis is perpendicular to the substrate surface.

The crystallinity of the AlN single crystal thin film of experiment No.723 and 724 is clearly superior to the AlN single crystal thin film of experiment No.709, it was confirmed that if it forms on the substrate which formed beforehand the polycrystalline thin film and an orientated polycrystalline thin film the single crystal thin film which is more excellent in crystallinity than forming directly on the substrate which consists of a sintered compact which comprises an aluminum nitride as the main ingredients is easy to be obtained.

Even if the polycrystalline thin film and orientated polycrystalline thin film which are formed beforehand are based not only on the sputtering method but also on the ion-plating method, and the MOCVD method, etc., they have confirmed on it that the single crystal thin film of excellent crystallinity was producible.

Although the appearance of the above-mentioned thin film produced in experiment No.721 and 722 was investigated, defects, such as a crack and a crevice, are not seen.

Although the exfoliation test by pressure sensitive adhesive tape was performed, exfoliation was not seen between the substrates which consist of a sintered compact which comprises an aluminum nitride as the main ingredients.

Although the appearance of the above-mentioned thin film produced in experiment No.723 and 724 was investigated, in all, defects, such as a crack and a crevice, are not seen.

Although the exfoliation test by pressure sensitive adhesive tape was performed, in all the thin films, exfoliation was not seen between the substrates which consist of a sintered compact which comprises an aluminum nitride as the main ingredients, or between thin films.

Although the thin film conductivity material of Ti/Pt/Au was formed on the surface of the thin film produced in experiment No.721-724, the metal lead was soldered and perpendicular tensile strength was investigated, it all is not less than 2 Kg/mm², so it has joined firmly between the sintered compact which comprises an aluminum nitride as the main ingredients and each above-mentioned thin film, or between each thin film.

In experiment No.725 of Table 31, the characteristic of the AlN thin film formed directly on the substrate which consists of a sintered compact which comprises an aluminum nitride as the main ingredients in the thickness of 3 μm is shown.

This AlN thin film uses an aluminium chloride as a raw material, and is produced by the Chloride VPE method of the same conditions as Example 9.

It was confirmed that C axis is perpendicularly formed to a substrate surface by X ray diffraction, and this thin film is a single crystal.

The half width of the rocking curve of the X ray diffraction line from the lattice plane of the Miller Index (002) of this single crystal thin film was 177 seconds.

In experiment No.726 and 727, the characteristic of the AlN thin film formed furthermore in the thickness of 3 μm by the Chloride VPE method of the same conditions as the above-mentioned experiment No.725 on it by using the substrate on which the AlN amorphous thin film and the AlN orientated polycrystalline thin film which were produced by the same sputtering conditions as experiment No.706 and experiment No.708 were respectively formed beforehand in the thickness of 3 μm is shown.

This thin film is clearly the single crystal formed in the direction where C axis is perpendicular to the substrate surface as a result of X ray diffraction.

The half width of the rocking curve of the X ray diffraction line from the lattice plane of the Miller Index (002) of the AlN single crystal thin film currently formed on the substrate which formed beforehand these AlN amorphous thin films and an AlN orientated polycrystalline thin film is 91 seconds and 86 seconds, respectively, it was clearly superior to 177 seconds of the AlN single crystal thin film of experiment No.725 produced by the Chloride VPE method of the same conditions.

Thus, also in the single crystal thin film produced not only by the MOCVD method but also by a Chloride VPE method, it was confirmed that if it forms on it by using the substrate which formed beforehand an amorphous thin film and an orientated polycrystalline thin film, the single crystal thin film which is more excellent in crystallinity than forming directly on the substrate which consists of a sintered compact which comprises an aluminum nitride as the main ingredients is producible.

Although the appearance of the above-mentioned thin film produced in experiment No.725 was investigated, defects, such as a crack and a crevice, are not seen.

Although the exfoliation test by pressure sensitive adhesive tape was performed, exfoliation was not seen between the substrates which consist of a sintered compact which comprises an aluminum nitride as the main ingredients.

Although the appearance of the above-mentioned thin film produced in experiment No.726 and 727 was investigated, in all, defects, such as a crack and a crevice, are not seen.

Although the exfoliation test by pressure sensitive adhesive tape was performed, in all the thin films, exfoliation was not seen between the substrates which consist of a sintered compact which comprises an aluminum nitride as the main ingredients, or between thin films.

Although perpendicular tensile strength was investigated by soldering the metal lead after the thin film conductivity materials of Ti/Pt/Au were formed on the surface of the thin films which were produced in the above-mentioned experiment No.725-727 and were produced using the Chloride VPE method, all are not less than 2 Kg/mm², so it has joined firmly between the sintered compact which comprises an aluminum nitride as the main ingredients and each above-mentioned thin film, or between each thin film.

In experiment No.728-731 of Table 31, the characteristic of a 100 mol % GaN thin film and a 100 mol % InN thin film which were formed directly on the substrate which consists of a sintered compact which comprises an aluminum nitride as the main ingredients in the thickness of 3 μm is shown.

This thin film is formed by the MOCVD method.

The GaN thin film shown in experiment No. 728, 729, and 730 is produced from the same raw material and by the same conditions of thin film formation as Example 1, Example 12, and Example 17, except having made substrate temperature into 330 degrees C., 380 degrees C., and 440 degrees C., respectively.

The InN thin film shown in experiment No. 731 is produced from the same raw material and by the same conditions of thin film formation as Example 1 and Example 12, except having made substrate temperature into 420 degrees C.

Consequently, among GaN thin films by X ray diffraction, the thing of experiment No. 728 was amorphous, and the thing of experiment No. 729 was a polycrystalline substance which has the diffraction peak of the Miller Index (002), (101).

In the obtained GaN thin film and an InN thin film, experiment No. 730 and 731 were the orientated polycrystal of which C axis was all formed in the perpendicular direction to the substrate surface, and the half width of the rocking curve of the X ray diffraction line from the lattice plane of a Miller Index (002) was 4710 seconds in the case of GaN thin film, and 4820 seconds in the case of InN thin film.

The characteristic of the AlN thin film, the GaN thin film, and the InN thin film which were produced in the thickness of 3 μm, respectively by the MOCVD method of the same conditions as the case of producing a thin film in experiment No. 709, and 714, and 715 of this Example further on it by using the substrate on which the GaN thin film and the InN orientated polycrystalline thin film were formed beforehand by the same conditions as the above-described MOCVD method is shown.

Each thin film formed after was clearly the single crystals of which C axis was formed in the perpendicular direction to the substrate surface in all as a result of X ray diffraction.

As it is shown in Table 31, the half width of the rocking curve of the X ray diffraction line from the lattice plane of the Miller Index (002) of these single crystal thin films was not more than 100 seconds in all, and what has high crystallinity.

Thus, by beforehand forming a GaN thin film and an InN thin film which have each crystallized state of an amorphous state, a polycrystal, and an orientated polycrystal directly on the substrate which consists of a sintered compact which comprises an aluminum nitride as the main ingredients, the single crystal thin film which comprises as the main ingredients at least one or more materials selected from a gallium nitride, an indium nitride, and an aluminum nitride on it can be formed, it was confirmed that the crystallinity can be raised than the single crystal thin film formed directly on the substrate which consists of a sintered compact which comprises an aluminum nitride as the main ingredients.

Although the appearance of the above-mentioned thin film produced in experiment No. 728-731 was investigated, defects, such as a crack and a crevice, are not seen.

Although the exfoliation test by pressure sensitive adhesive tape was performed, exfoliation was not seen between the substrates which consist of a sintered compact which comprises an aluminum nitride as the main ingredients.

The appearance of each thin film produced in experiment No. 732-739 was investigated, in all, defects, such as a crack and a crevice, are not seen.

Although the exfoliation test by pressure sensitive adhesive tape was performed, in all the thin films, exfoliation was not seen between the substrates which consist of a sintered compact which comprises an aluminum nitride as the main ingredients, or between thin films. Although the thin film conductivity material of Ti/Pt/Au was formed on the surface of the thin film produced in the above-mentioned experiment No. 728-739, the metal lead was soldered and perpendicular tensile strength was investigated, it all is not less than 2 Kg/mm², so it has joined firmly between the sintered compact which comprises an aluminum nitride as the main ingredients and each above-mentioned thin film, or between each thin film.

Although FIG. 62 shows the X ray diffraction pattern measured in the range of 2θ:10 degrees (degree) −70 degrees (degree) as diffraction angle with 2θ/0 scan of the AlN amorphous thin film produced in experiment No. 706, a clear peak does not appear, but it has become a broad pattern, and it seems that it is in an amorphous state clearly.

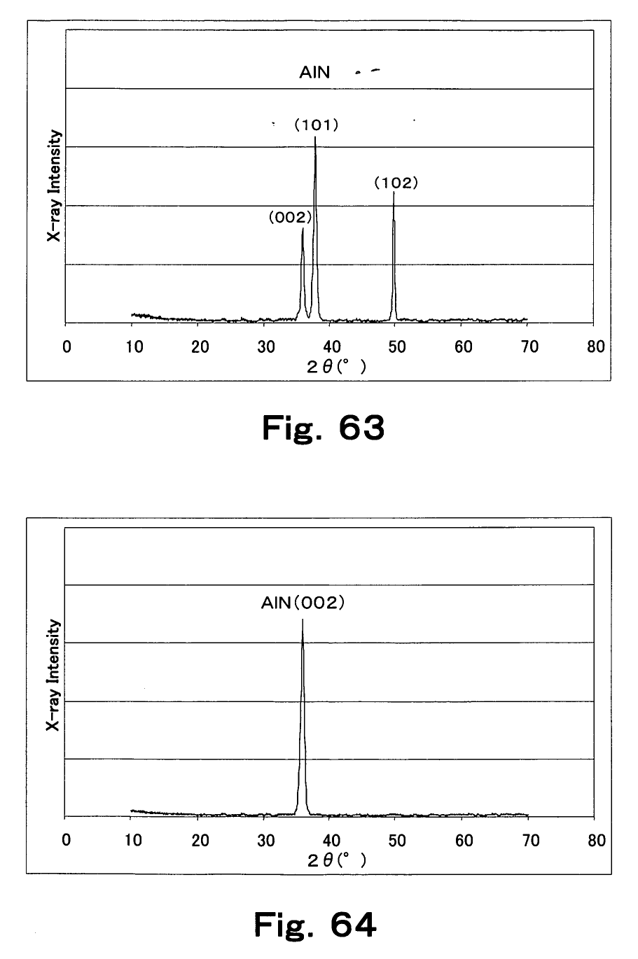

Although FIG. 63 shows the X ray diffraction pattern measured in the range of 2θ:10 degrees (degree) −70 degrees (degree) as diffraction angle by 2θ/0 scan about the AlN polycrystalline thin film produced in experiment No. 707, the peaks have appeared from each lattice plane of a Miller Index (002), (101), (102), and it is a polycrystal clearly. Although FIG. 64 shows the X ray diffraction pattern measured in the range of 2θ:10 degrees (degree) −70 degrees (degree) as diffraction angle by 2θ/0 scan about the AlN orientated polycrystalline thin film produced in experiment No. 708, the peak has appeared only from the lattice plane of a Miller Index (002), and it is clearly the orientated polycrystal which was formed in the direction where C axis is perpendicular to the substrate surface.

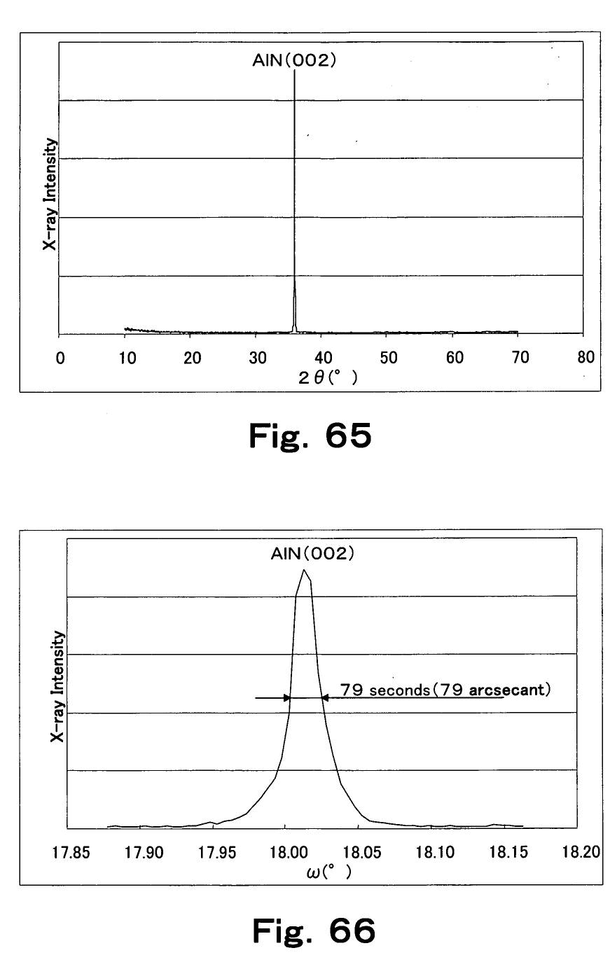

Although FIG. 65 shows the X ray diffraction pattern measured in the range of 2θ:10 degrees (degree) −70 degrees (degree) as diffraction angle by 2θ/0 scan about the AlN single crystal thin film produced in experiment No. 712, the peak has appeared only from the lattice plane of a Miller Index (002), the peak is extremely sharp than the AlN orientated polycrystalline thin film of experiment No. 708, it is clearly the single crystal formed in the direction where C axis is perpendicular to the substrate surface.

FIG. 66 is the rocking curve of the X ray diffraction line from the lattice plane of the Miller Index (002) measured in the range of 17.88 degrees (degree) −18.16 degrees (degree) as diffraction angle by ω scan about the single crystal thin film produced in the above-mentioned experiment No. 712.

It is also described together in FIG. 66 that the half width of the rocking curve of this thin film is 79 seconds (79 arcsecant).

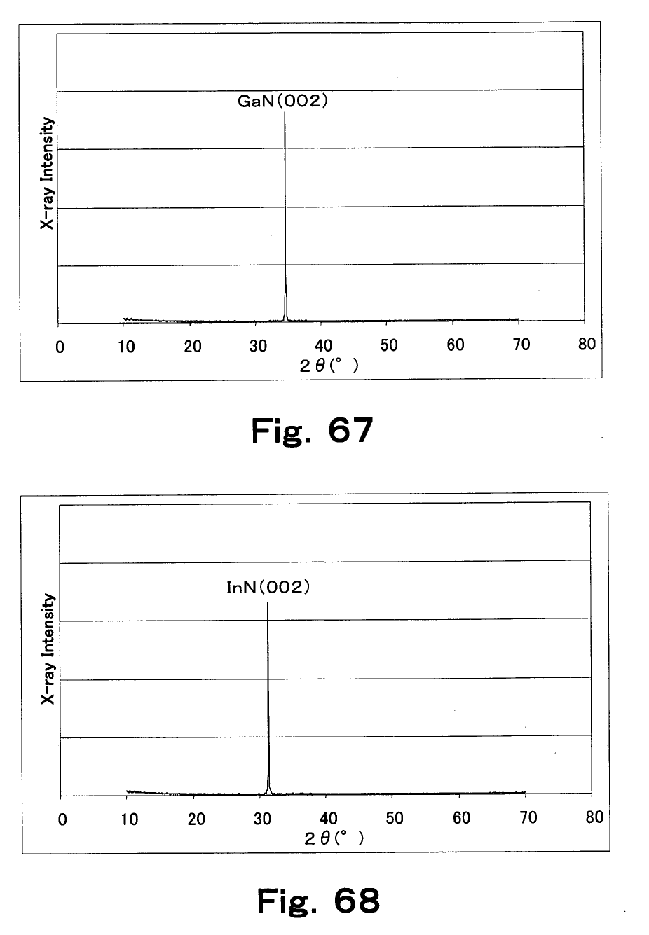

Although FIG. 67 shows the X ray diffraction pattern measured in the range of 2θ:10 degrees (degree) −70 degrees (degree) as diffraction angle by 2θ/0 scan about the GaN single crystal thin film produced in experiment No. 716, the peak has appeared only from the lattice plane of a Miller Index (002), the peak is also sharp, it is clearly the single crystal formed in the direction where C axis is perpendicular to the substrate surface.

Although FIG. 68 shows the X ray diffraction pattern measured in the range of 2θ:10 degrees (degree) −70 degrees (degree) as diffraction angle by 2θ/0 scan about the InN single crystal thin film produced in experiment No. 717, the peak has appeared only from the lattice plane of a Miller Index (002), the peak is also sharp, it is clearly the single crystal formed in the direction where C axis is perpendicular to the substrate surface.

The X ray diffraction pattern shown in FIG. 62-FIG. 68 was measured using CuKα line.

In the X ray diffraction pattern shown in FIG. 62-FIG. 65 and FIG. 67-FIG. 68, the horizontal axis of each figure shows diffraction angle: 2θ, the vertical axis shows the intensity of diffraction X-rays (X-ray Intensity).

In the X ray diffraction pattern shown in FIG. 66, a horizontal axis shows diffraction angle: ω, the vertical axis shows the intensity of diffraction X-rays (X-ray Intensity).

In this Example, although the surface roughness of the substrate surface in the state where the thin film was formed was measured, the surface roughness Ra in all the substrates produced was not more than 10 nm as shown in Table 31.

Thus, it was confirmed that it becomes smaller extremely than the surface roughness of the original substrate which consists of a sintered compact which comprises an aluminum nitride as the main ingredients, and the flat and smooth thin film substrate which improved is easy to be obtained.

As mentioned above, in the substrate which formed the single crystal thin film further on the substrate on which the thin film of an amorphous state, a polycrystal, an orientated polycrystal, and a single crystal was formed beforehand on the substrate which consists of a sintered compact which comprises an aluminum nitride as the main ingredients, it was confirmed that surface roughness becomes small and surface smooth nature is improved (the surface roughness of the single crystal thin film of the substrate surface produced in experiment example 710-713, 716-719, 723-724, 726-727, and 732-739 is smaller than the thin film produced in experiment example 706-709, 714-715, 721-722, and 728-731).

In an amorphous thin film, a polycrystalline thin film, and an orientated polycrystalline thin film which are formed directly on the substrate which consists of a sintered compact which comprises an aluminum nitride as the main ingredients, it is preferred to use the substrate on which the orientated polycrystalline thin film was formed.

In this Example, while the surface roughness of the single crystal thin film (experiment No. 710, 711, 718, 719, 724, and 726) formed on it by using the substrate which formed beforehand the AlN amorphous thin film and the AlN polycrystalline thin film on the substrate which consists of a sintered compact which comprises an aluminum nitride as the main ingredients is the range of Ra: 2.0 nm-2.5 nm, the surface roughness of the single crystal thin film (experiment No. 712, 716, 717, 720, and 727) formed on it by using the substrate which formed beforehand the orientated polycrystal is in the range of Ra: 0.87 nm -1.09 nm, it was confirmed that surface smooth nature is further excellent.

Next, the thin film formed by using the substrate from which the quality of the material (composition, a crystal phase, optical transmissivity, size of a sintered compact crystal grain, etc.) of the sintered compact which comprises an aluminum nitride as the main ingredients differs was evaluated.

Formation of a thin film was performed under the same conditions as what was described in the above-mentioned this Example.

The result is shown in experiment No. 740-757 of Table 32.

In experiment No. 740-757, clearly, 1) even if the quality of the material of the substrate which consists of a sintered compact which comprises an aluminum nitride as the main ingredients differs, as for the single crystal thin film formed on it by using the substrate which formed beforehand an amorphous state, a polycrystal, and an orientated polycrystal, even if it is not only AlN but also GaN and InN, the half width of the rocking curve of the X ray diffraction line from the lattice plane of a Miller Index (002) is not more than 100 seconds, i.e., what is high crystallinity is obtained, and it was equivalent at least or excelling it further was confirmed if it is compared with the crystallinity of the single crystal thin film (single crystal thin film produced in experiment No. 740, 744, 749, and 753) directly formed on the substrate which consists of a sintered compact which comprises an aluminum nitride as the main ingredients.

Moreover, 2) it was confirmed that the surface smooth nature of the substrate which consists of a sintered compact which formed the thin film and comprises an aluminum nitride as the main ingredients is superior to the surface smooth nature of the substrate which consists only of a sintered compact which comprises an aluminum nitride as the main ingredients.

3) it was confirmed that the surface smooth nature of the thin film formed on the substrate which formed beforehand an amorphous thin film, a polycrystalline thin film, and an orientated polycrystalline thin film is superior to the surface smooth nature of the thin film which formed directly on the substrate which consists of a sintered compact which comprises an aluminum nitride as the main ingredients.

4) it was confirmed that the surface smooth nature of the single crystal thin film formed on the substrate in which the orientated polycrystalline thin film was formed is superior to the substrate in which the amorphous thin film and the polycrystalline thin film were formed among the thin film which was formed beforehand on the substrate which consists of a sintered compact which comprises an aluminum nitride as the main ingredients.

Although the appearance of the above-mentioned thin film produced in experiment No. 740-757 was investigated, in all, defects, such as a crack and a crevice, are not seen.

Although the exfoliation test by pressure sensitive adhesive tape was performed, in all the thin films, exfoliation was not seen between the substrates which consist of a sintered compact which comprises an aluminum nitride as the main ingredients, or between thin films.

Although the thin film conductivity material of Ti/Pt/Au was formed on each formed above-mentioned single crystal thin film, the metal lead was soldered and perpendicular tensile strength was investigated, it all is not less than 2 Kg/mm², so it has joined firmly between the sintered compact which comprises an aluminum nitride as the main ingredients and each above-mentioned thin film, or between each thin film.

In this Example, the above phenomena were confirmed also in what used as a substrate the various sintered compacts which comprise an aluminum nitride as the main ingredients and which has the conduction via which comprises tungsten and copper as the main ingredients.

That is, the result is shown in experiment No. 758-765 of Table 32.

The thin film which is formed beforehand directly on the substrate which consists of a sintered compact which comprises an aluminum nitride as the main ingredients and which has a conduction via and is shown in experiment No. 758-765 was produced by using the sputtering method and the MOCVD method according to the same conditions as what was indicated in this above-mentioned Example.

AlN, GaN, and an InN thin film were formed furthermore on the substrate in which each thin film was formed beforehand by the MOCVD method and the Chloride VPE method under the same conditions as what was shown in the above-mentioned this Example.

Each formed AlN, GaN, InN thin film was the single crystal whose C axis was formed in the perpendicular direction to the substrate surface, and they were the single crystals which have the excellent crystallinity in which the half width of the rocking curve of the X ray diffraction line from the lattice plane of a Miller Index (002) is not more than 100 seconds altogether.

Thus, also in the substrate which consists of a sintered compact which comprises an aluminum nitride as the main ingredients and which has a conduction via, the single crystal thin film which comprises as the main ingredients at least one or more materials selected from a gallium nitride, an indium nitride, and an aluminum nitride can be formed on it by forming beforehand the AlN thin film which has each crystallized state of an amorphous state, a polycrystal, and an orientated polycrystal, GaN thin film of orientated polycrystal, and InN thin film of orientated polycrystal, it was confirmed that the crystallinity rises than the single crystal thin film which was formed directly on the substrate which consists of a sintered compact which comprises an aluminum nitride as the main ingredients.

The surface smooth nature of the above-mentioned single crystal thin film produced in experiment No. 758-765 was superior to the surface smooth nature of the substrate which consists of a sintered compact which comprises an aluminum nitride as the main ingredients.

It was confirmed that the surface smooth nature of the single crystal thin film which was formed on the substrate which formed the orientated polycrystalline thin film is superior to the substrate (examples 760 and 764 of an experiment) which formed an amorphous thin film and a polycrystalline thin film among the thin films which were formed beforehand on the substrate which consists of a sintered compact which comprises an aluminum nitride as the main ingredients.

The appearance of the above-mentioned thin film produced in experiment No. 758-765 was investigated, in all, defects, such as a crack and a crevice, are not seen.

Although the exfoliation test by pressure sensitive adhesive tape was performed, in all the thin films, exfoliation was not seen between the substrates which consist of a sintered compact which comprises an aluminum nitride as the main ingredients, or between thin films.

Although the thin film conductivity material of Ti/Pt/Au was formed on each formed above-mentioned single crystal thin film, the metal lead was soldered and perpendicular tensile strength was investigated, it all is not less than 2 Kg/mm², so it has joined firmly between the sintered compact which comprises an aluminum nitride as the main ingredients and each above-mentioned thin film, or between each thin film.

The example in which the thin film which contains a doping ingredient was formed on the substrate which consists of a sintered compact which comprises an aluminum nitride as the main ingredients is shown in Table 33.

The thin film in each experiment indicated in Table 33 was produced so that it might be set to 3 μm as thickness.

Experiment No. 766-775 are the example in which the thin film which contains a doping ingredient was formed directly on the substrate which consists of a sintered compact which comprises an aluminum nitride as the main ingredients.

The example of the thin film produced by the sputtering method in which the GaN single crystal containing 0.02 mol % Si ingredient was used as the target is shown in experiment No. 766.

The example of the thin film produced by the sputtering method in which the high purity InN sintered compact containing 0.02 mol % Si ingredient was used as the target is shown in experiment No. 767.

The example of the thin film produced by the sputtering method in which the high purity AlN sintered compact containing 0.02 mol % Si ingredient was used as the target is shown in experiment No. 768.

The thin film of experiment No. 766 is what was produced by the sputtering method under the condition of which the substrate temperature was made into room temperature, the mixed gas of Ar+N₂ was introduced with the mixture ratio of N₂/Ar=0.6, the pressure inside the chamber was 0.5 Pa, and electric power was 400 W.

The thin film of experiment No. 767 is what was produced by the sputtering method under the condition of which the substrate temperature was made into 250 degrees C., the mixed gas of Ar+N₂ was introduced with the mixture ratio of N₂/Ar=0.3, the pressure inside the chamber was 0.6 Pa, and electric power was 600 W.

The thin film of experiment No. 768 is what was produced by the sputtering method under the condition of which the substrate temperature was made into 280 degrees C., the mixed gas of Ar+N₂ was introduced with the mixture ratio of N₂/Ar=0.4, the pressure inside the chamber was 0.8 Pa, and electric power was 1000 W.

The electric power used in the above described sputtering method is high frequency with a frequency of 13.56 MHz.

Experiment No. 769 and 770 show the example of the thin film produced by the MOCVD method of the same conditions as the above-mentioned this Example except having made substrate temperature into 480 degrees C., and having newly used SiH₄ as a raw material for doping.

The thin film produced in experiment No. 766 was amorphous and the thin film produced in experiment No. 767 was a polycrystal in which the diffraction line of the lattice plane of a Miller Index (002), (101), and (102) has appeared as a result of X ray diffraction.

On the other hand, the thin films produced in experiment No. 768, 769, and 770 were the orientated polycrystal in which only the diffraction line of the lattice plane of a Miller Index (002) has appeared, and C axis was perpendicularly formed to the substrate surface.

The half width of the rocking curve of the X ray diffraction line from the lattice plane of the Miller Index (002) of these orientated polycrystalline thin films is 7930 seconds, 4560 seconds, and 4390 seconds, respectively, the orientated polycrystalline thin film produced by the MOCVD method was more excellent in crystallinity.

The thin film produced in experiment No. 766-770 all had conductivity as shown in Table 33. The appearance of the above-mentioned thin film produced in experiment No. 766-770 was investigated, in all, defects, such as a crack and a crevice, are not seen.

Although the exfoliation test by pressure sensitive adhesive tape was performed, in all the thin films, exfoliation was not seen between the substrates which consists of a sintered compact which comprises an aluminum nitride as the main ingredients.

Although the thin film conductivity material of Ti/Pt/Au was formed on each formed above-mentioned orientated polycrystalline thin film, the metal lead was soldered and perpendicular tensile strength was investigated, it all is not less than 2 Kg/mm², so it has joined firmly between the sintered compact which comprises an aluminum nitride as the main ingredients and each above-mentioned thin film.

Experiment No. 771-775 are also the example which formed directly the thin film which contains a doping ingredient on the substrate which consists of a sintered compact which comprises an aluminum nitride as the main ingredients.

They are the examples of the thin film which was produced by the MOCVD method of the same conditions as Example 1 except that the substrate temperature was made into 1100 degrees C. in the case of the thin film of experiment No. 771, and the substrate temperature was made into 1000 degrees C. in the case of the thin film of experiment No. 772 and 773, and the substrate temperature was made into 840 degrees C. in the case of the thin film of experiment No. 774 and 775, SiH₄, Bis-cyclopentadienyl magnesium, and diethyl zinc were newly used as a raw material for doping.

These thin films all were the single crystals with which C axis was perpendicularly formed to the substrate surface as a result of X ray diffraction, and the half width of the rocking curve of the X ray diffraction line from the lattice plane of a Miller Index (002) was 171 seconds, 157 seconds, 182 seconds, 192 seconds, and 197 seconds, respectively.

All had conductivity, as shown in Table 33.

The appearance of the above-mentioned thin film produced by experiment No. 771-775 was investigated, in all, defects, such as a crack and a crevice, are not seen.

Although the exfoliation test by pressure sensitive adhesive tape was performed, in all the thin films, exfoliation was not seen between the substrates which consists of a sintered compact which comprises an aluminum nitride as the main ingredients.

Although the thin film conductivity material of Ti/Pt/Au was formed on each formed above-mentioned single crystal thin film, the metal lead was soldered and perpendicular tensile strength was investigated, it all is not less than 2 Kg/mm², so it has joined firmly between the sintered compact which comprises an aluminum nitride as the main ingredients and each above-mentioned single crystal thin film.

Next, the orientated polycrystalline thin film of same composition which has the same doping ingredient as above-mentioned experiment No. 768 and 770 was formed beforehand on the substrate which consists of a sintered compact which comprises an aluminum nitride as the main ingredients by the sputtering method and MOCVD method of the same thin film formation conditions, formation of the single crystal thin film which has a doping ingredient was tried on it by the MOCVD method of the same thin film formation conditions as the above-mentioned experiment No. 771-775.

The result was shown in Table 34.

As for the thin films which are formed on the substrate which consists of a sintered compact which comprises an aluminum nitride as the main ingredients and which formed beforehand the orientated polycrystalline thin film by the above described sputtering method and MOCVD method which are shown in experiment No. 776-785 of Table 34, all were a single crystal whose C axis was perpendicularly formed to the substrate surface.

The half width of the rocking curve of the X ray diffraction line from the lattice plane of the Miller Index (002) of these single crystal thin films is in the range of 80 seconds-95 seconds, it was confirmed that crystallinity was improving clearly while the single crystal thin film directly formed on the substrate which consists of a sintered compact which comprises an aluminum nitride as the main ingredients and was produced in experiment No. 771-775 is 157 seconds-197 seconds.

The single crystal thin film formed on the orientated polycrystalline thin film all had conductivity, as shown in Table 34.

While the surface roughness of the single crystal thin film which was formed directly on the substrate which consists of a sintered compact which comprises an aluminum nitride as the main ingredients and was produced in experiment No. 771-775 is in the range of 4.6 nm -7.1 nm, the surface roughness of the single crystal thin film formed on the orientated polycrystalline thin film produced in experiment No. 776-785 is in the range of Ra 0.87 nm -1.01 nm, it was confirmed that surface roughness was also improved clearly.

Although the appearance of the above-mentioned thin films produced in experiment No. 758-765 was investigated, defects, such as a crack and a crevice, are not seen in the orientated polycrystalline thin film at the substrate side and in the single crystal thin film at the surface altogether.

Although the exfoliation test by pressure sensitive adhesive tape was performed, in all the thin films, exfoliation was not seen between the substrates which consists of a sintered compact which comprises an aluminum nitride as the main ingredients, or between thin films.

Although the thin film conductivity material of Ti/Pt/Au was formed on the single crystal thin film produced in experiment No. 776-785, the metal lead was soldered and perpendicular tensile strength was investigated, it all is not less than 2 Kg/mm², so it has joined firmly between the sintered compact which comprises an aluminum nitride as the main ingredients and the orientated thin film, and between the orientated thin film and the single crystal thin film.

It is although not indicated in Table 34, the further formation of a single crystal thin film which has a doping ingredient by the MOCVD method of the same thin film formation conditions and in the same composition as the time of producing in the above-mentioned experiment No. 771-775 on it was tried after beforehand forming an amorphous thin film, a polycrystalline thin film, and an orientated polycrystalline thin film on the substrate (what was produced in experiment No. 49) which consists of a sintered compact which comprises an aluminum nitride as the main ingredients by the sputtering method and the MOCVD method of the same thin film formation conditions and in the same composition as experiment No. 766, 767, and 769 independently.

Consequently, the same amorphous thin film, the polycrystalline thin film, and the orientated polycrystalline thin film as the above-mentioned experiment No. 766, 767, and 769 are formed on the substrate which consists of a sintered compact which comprises an aluminum nitride as the main ingredients, and the thin film formed on those thin films all was the single crystal with which C axis was perpendicularly formed to the substrate surface.

All the half width of the rocking curve of the X ray diffraction line from the lattice plane of the Miller Index (002) of these single crystal thin films is not more than 100 seconds, it was confirmed that the crystallinity was clearly improved more than the single crystal thin film which was produced in experiment No. 743-747 and was formed directly on the substrate which consists of a sintered compact which comprises an aluminum nitride as the main ingredients.

As for the surface roughness of the above-mentioned single crystal thin film, it is in the range of Ra 2.1 nm -2.7 nm in the case of what was formed on the amorphous thin film, it is in the range of Ra 1.8 nm -2.5 nm in the case of what was formed on the polycrystalline thin film, and it is in the range of Ra 0.89 nm -1.08 nm in the case of what was formed on the orientated polycrystalline thin film, it was confirmed that surface roughness was also improved clearly.

As a thin film which is formed beforehand on the substrate which consists of a sintered compact which comprises an aluminum nitride as the main ingredients as mentioned above, it was confirmed that there is a tendency to give better surface smooth nature by a single crystal thin film formed on it if it is an orientated polycrystal like what was shown in Table 31.

Thus, in this Example, even when the single crystal thin film which includes a doping ingredient and comprises as the main ingredients at least one or more materials selected from a gallium nitride, an indium nitride, an aluminum nitride is formed on the substrate which consists of a sintered compact which comprises an aluminum nitride as the main ingredients, it was confirmed that it was more effective to use the substrate on which the orientated polycrystal was formed beforehand than forming directly on a substrate.

### EXAMPLE 26

In this Example, the effect of the thin film formed beforehand on the substrate which consists of a sintered compact which comprises an aluminum nitride as the main ingredients was examined further.

It was examined using what is various compositions produced in Example 19 as it is as a substrate which consists of a sintered compact which comprises an aluminum nitride as the main ingredients.

Moreover, the sintered compact of various compositions which comprises an aluminum nitride as the main ingredients was newly produced by carrying out normal pressure sintering of the powder compact by the same method as Example 19 at 1800 degrees C. for 2 hours in N₂, then specular surface polish of the obtained sintered compact was carried out like Example 19, and it used as a substrate for thin film formation.

In addition, in the various sintered compacts which comprise an aluminum nitride as the main ingredients and were newly produced, the quantity of the impurities contained in a powder compact or the various additives added is what converted the impurities actually contained or the compound added into the oxide or the element, like Example 19.

In the sintered compact which comprises an aluminum nitride as the main ingredients and was produced in this Example, it was confirmed that impurities oxygen in raw material powder and the oxygen resulting from added Al₂O₃, or the metal ingredient and the oxygen ingredient, etc. in sintering aids, such as an added rare earth element compound and an alkaline-earth-metals compound, or the metal ingredient and the oxygen ingredient, etc. in the alkali metal compound and silicon content compound which were added, or the metal ingredient and carbon ingredient, etc. in the compound containing each transition metal of Mo, W, V, Nb, Ta, and Ti and the compound containing carbon which were added, or the metal ingredient, etc. in the compound containing unescapable metal, such as Fe, Ni, Cr, Mn, Zr, Hf, Co, Cu, and Zn, etc. which were added, are hardly vaporized and removed by firing, either, but the almost same quantity as the quantity in a powder compact exist.

That is, in this Example, when the above-mentioned converted value was used as an amount of impurities and an amount of additives like Example 19, the difference between the quantity of the impurities or the additives in the produced sintered compact which comprises an aluminum nitride as the main ingredients and the quantity of the impurities or the additives contained in a powder compact is small, it can be considered that it is almost the same amount.

Therefore, the composition of an obtained sintered compact which comprises an aluminum nitride as the main ingredients is not indicated especially in each Table except the total amount of oxygen.

The details of the substrate which consists of a sintered compact which comprises an aluminum nitride as the main ingredients and which was used in this Example and was newly produced in this Example were shown in Table 35-40.

On these substrates, forming beforehand the single crystal thin film, an amorphous thin film, a polycrystalline thin film, and an orientated polycrystalline thin film which comprise as the main ingredients at least one or more materials selected from a gallium nitride, an indium nitride, and an aluminum nitride, the effect which gives to the characteristic of the single crystal thin film formed furthermore on it was examined.

First, the composition is made 100 mol % AlN as a thin film formed beforehand on a substrate, what has a thickness of 3 μm was produced by the same method as the sputtering method performed in experiment No. 706, 707, and 708 and by the MOCVD method performed in experiment No. 709 of Example 25.

The composition is made 100 mol % AlN, 100 mol % GaN, 100 mol % InN, 50 mol % AlN+50 mol % GaN, and 50 mol % GaN+50 mol % InN as the thin film formed on it, they produced so that the substrate which consists of a sintered compact which comprises an aluminum nitride as the main ingredients in Example 19 and the single crystal thin film which was formed directly on this sintered compact substrate might become correspondence of the same composition.

All the thickness of the formed thin film was 3 μm.

As a forming method, it carried out like a description in Example 19 by the MOCVD method by the same conditions as Example 1 and Example 2.

The characteristics of the thin film produced like that were shown in Table 35, Table 36, Table 37, Table 38, Table 39, and Table 40.

Next, analysis by X ray diffraction was performed about the AlN thin films which were formed beforehand on each substrate which consists of a sintered compact which comprises an aluminum nitride as the main ingredients, it was confirmed that the AlN thin films produced by the sputtering method of the same conditions as experiment No. 706, 707, and 708 of above-mentioned Example 25 corresponds to experiment No. 706, and 707 and 708, they are an amorphous state, a polycrystal, and an orientated polycrystal, respectively.

It was confirmed that the AlN thin film produced by the MOCVD method of the same conditions as experiment No. 709 of above-mentioned Example 25 corresponds to experiment No. 709, it is a single crystal.

These results were indicated in Table 35-40.

As for what is an orientated polycrystal and a single crystal thin film among these AlN thin films formed beforehand, it was confirmed that C axis is perpendicularly formed to a substrate surface.

As for the crystallinity, the measured value of the half width of the rocking curve of the X ray diffraction line from the lattice plane of a Miller Index (002) was in the range of 6640 seconds-7550 seconds in the case of an orientated polycrystalline thin film, and in the range of 138 seconds -235 seconds in-the case of a single crystal thin film as shown in Table 35-40.

Next, by using the substrate which formed beforehand the thin film of the above-mentioned various crystallized states, the thin films which formed furthermore on it were investigated by X ray diffraction, it was confirmed that they all are clearly the single crystal in which C axis is formed perpendicularly to the substrate surface.

The examples using the substrate which consists of a sintered compact which comprises an aluminum nitride as the main ingredients and added A1₂O₃ as an additive are shown in Table 35.

In Table 35, all the substrate that consist of a sintered compact which comprises an aluminum nitride as the main ingredients and which is indicated in Table 18 and is produced in Example 19 are used as they are, except the substrate which consists of a sintered compact which comprises an aluminum nitride as the main ingredients and which was used in experiment No. 802 and 803 and was produced by adding Al₂O₃ 56 volume % by oxide conversion.

As shown in each experiment of Table 35, in all the substrates which consist of a sintered compact which comprises an aluminum nitride as the main ingredients and formed beforehand the thin film which consists of various crystallized states, such as an amorphous state, a polycrystal, an orientated polycrystal, and a single crystal etc., the single crystal thin film which comprises as the main ingredients at least one or more materials selected from a gallium nitride, an indium nitride, and an aluminum nitride has been formed on these.

This single crystal thin film was what has the crystallinity not more than 300 seconds as half width of the rocking curve of the lattice plane of a Miller Index (002).

It has confirmed that the crystallinity of this single crystal thin film was improved than what formed directly on the same substrate which consists of a sintered compact which comprises an aluminum nitride as the main ingredients.

When using what formed beforehand the thin film which consists of various crystallized states, such as an amorphous state, a polycrystal, an orientated polycrystal, and a single crystal etc., on the substrate which consists of a sintered compact which comprises an aluminum nitride as the main ingredients and was indicated in Table 35 of this Example, as for the single crystal thin film formed on it, though the half width of the rocking curve of the lattice plane of the Miller Index (002) of this single crystal thin film was not less than 100 seconds in the substrates which contain ALON not less than 50%, it was not more than 100 seconds in many in the other substrates which contain ALON not more than 50%.

As for the substrate which consists of a sintered compact which comprises an aluminum nitride as the main ingredients and added Al₂O₃ as an additive, even if it is what cannot directly form a single crystal thin film on it, if what formed beforehand the thin film which consists of various crystallized states, such as an amorphous state, a polycrystal, and an orientated polycrystal etc., is used as a substrate as shown in Table 35 in this Example, it was confirmed that the single crystal thin film which comprises as the main ingredients at least one or more materials selected from a gallium nitride, an indium nitride, and an aluminum nitride on it could be formed.

As shown in experiment No. 382 of Table 18 of Example 19, an ALON phase of 59% arises in addition to an AlN phase in the sintered compact which comprises an aluminum nitride as the main ingredients and added Al₂O₃ 50 volume %, though direct formation of a single crystal thin film was difficult, in this Example, as shown in experiment No. 799-801, even if it used the same substrate, when beforehand forming the AlN thin film of an amorphous state, a polycrystal, and an orientated polycrystal, it was confirmed that the single crystal thin film of excellent crystallinity can be easily formed on it.

As shown in experiment No. 802 of Table 35 in this Example, the ALON phase of 77% was arising in the sintered compact which comprises an aluminum nitride as the main ingredients and added Al₂O₃ 56 volume % in addition to the AlN phase.

The thin film formed on the substrate using this sintered compact was a polycrystalline substance whose diffraction peak is shown only from the lattice plane of a Miller Index (002), (101), (102), and direct formation of a single crystal thin film was difficult on this substrate.

On the other hand, as shown in experiment No. 803, even if it used the substrate which consists of a same sintered compact, when beforehand forming the AlN thin film of an orientated polycrystal, it was confirmed that the single crystal thin film of excellent crystallinity can be easily formed on it.

The example using the substrate which consists of a sintered compact which comprises an aluminum nitride as the main ingredients and added a rare earth element and an alkaline-earth metal as an additive is shown in Table 36.

In Table 36, except for the substrate consisting of a sintered compact which was used in experiment No. 828 and 829 and which was produced by adding Y₂O₃ 72 volume % by oxide conversion and comprises an aluminum nitride as the main ingredients, all the substrates which consist of a sintered compacts which was produced in Example 19 and which is indicated in Table 19 and comprises an aluminum nitride as the main ingredients are used as they are.

As shown in each experiment of Table 36, in all the substrates which consist of a sintered compact which comprises an aluminum nitride as the main ingredients and formed beforehand the thin film which consists of various crystallized states, such as an amorphous state, a polycrystal, an orientated polycrystal, and a single crystal etc., the single crystal thin film which comprises as the main ingredients at least one or more materials selected from a gallium nitride, an indium nitride, and an aluminum nitride has been formed on these.

This single crystal thin film was what has the crystallinity not more than 300 seconds as half width of the rocking curve of the lattice plane of a Miller Index (002).

It has confirmed that the crystallinity of this single crystal thin film improved than what directly formed on the substrate which consists of a same sintered compact which comprises an aluminum nitride as the main ingredients.

When what formed beforehand the thin film which consists of various crystallized states, such as an amorphous state, a polycrystal, an orientated polycrystal, and a single crystal etc., on the substrate which consists of a sintered compact which comprises an aluminum nitride as the main ingredients and was indicated in Table 36 of this Example is used, as for the single crystal thin film formed on it, although the half width of the rocking curve of the lattice plane of the Miller Index (002) of this single crystal thin film was not less than 100 seconds in many in the substrates which contain at least one or more ingredients selected from a rare earth element and an alkaline-earth metal not less than 50 volume % by oxide conversion, it was not more than 100 seconds in many in the substrates which contain at least one or more ingredients selected from a rare earth element and an alkaline-earth metal not more than 50 volume % by oxide conversion.

As for the substrate which consists of a sintered compact which comprises an aluminum nitride as the main ingredients and contains a rare earth element and an alkaline-earth metal as an additive, even if it is what cannot directly form a single crystal thin film on it, when using as a substrate what formed beforehand directly the thin film which consists of various crystallized states, such as an amorphous state, a polycrystal, and an orientated polycrystal etc., it was confirmed that the single crystal thin film that comprises as the main ingredients at least one or more materials selected from a gallium nitride, an indium nitride, and an aluminum nitride can form on it, as shown in Table 36 in this Example.

As shown in experiment No. 391 and experiment No. 399 in Table 19 in Example 19, although direct formation of a single crystal thin film was difficult on the sintered compact which comprises an aluminum nitride as the main ingredients and added CaCO₃ of 54 volume % by oxide conversion and Y₂O₃ of 55 volume % by oxide conversion, in this Example, as shown in experiment No. 812-814 and experiment No. 825-827, even if it used the same substrate, when beforehand forming the AlN thin film of an amorphous state, a polycrystal, and an orientated polycrystal, it was confirmed that the single crystal thin film of excellent crystallinity can be easily formed on it.

All the half width of the rocking curve of the lattice plane of the Miller Index (002) of the single crystal thin film formed in these six experiments was not more than 130 seconds.

In addition, as shown in experiment No. 828 of Table 36 in this Example, the thin film formed on the substrate using the sintered compact which comprises an aluminum nitride as the main ingredients and added Y₂O₃ 72 volume % was a polycrystalline substance whose diffraction peak is shown only from the lattice plane of a Miller Index (002), (101), (102), and direct formation of a single crystal thin film was difficult on this substrate.

On the other hand, as shown in experiment No. 829, even if it uses the substrate which consists of the same sintered compact, when beforehand forming the AlN thin film of an orientated polycrystal, it was confirmed that the single crystal thin film of excellent crystallinity can be easily formed on it.

The example using the substrate which consists of a sintered compact which comprises an aluminum nitride as the main ingredients and added an alkaline metal and a silicon compound as an additive is shown in Table 37.

In Table 37, except for the substrate consisting of a sintered compact which was used in experiment No. 861-864 and which was produced by adding SiO₂ 50 volume % by oxide conversion and comprises an aluminum nitride as the main ingredients, all the substrates consisting of a sintered compact which was produced in Example 19 and which is indicated in Table 20 and comprises an aluminum nitride as the main ingredients are used as they are.

As shown in each experiment of Table 37, in all the substrates which consist of a sintered compact which comprises an aluminum nitride as the main ingredients and formed beforehand the thin film which consists of various crystallized states, such as an amorphous state, a polycrystal, an orientated polycrystal, and a single crystal etc., the single crystal thin film which comprises as the main ingredients at least one or more materials selected from a gallium nitride, an indium nitride, and an aluminum nitride has been formed on these.

This single crystal thin film was what has the crystallinity not more than 300 seconds as half width of the rocking curve of the lattice plane of a Miller Index (002).

It has confirmed that the crystallinity of this single crystal thin film improved than what was formed directly on the substrate which consists of a same sintered compact which comprises an aluminum nitride as the main ingredients.

When the thing what formed beforehand the thin film which consists of various crystallized states, such as an amorphous state, a polycrystal, an orientated polycrystal, and a single crystal etc., on the substrate which consists of a sintered compact which comprises an aluminum nitride as the main ingredients and is shown in Table 37 of this Example is used, as for the single crystal thin film formed on it, though the half width of the rocking curve of the lattice plane of the Miller Index (002) of this single crystal thin film was not less than 100 seconds in the substrates which contain at least one or more ingredients selected from an alkaline metal and silicon not less than 20 volume % by oxide conversion, it was not more than 100 seconds in many in the other substrates, i.e., in what contains at least one or more ingredients selected from an alkaline metal and silicon not more than 20 volume % by oxide conversion.

As for the substrate which consists of a sintered compact which comprises an aluminum nitride as the main ingredients and contains an alkaline metal and a silicon compound as an additive, even if it is what cannot directly form a single crystal thin film on it, in this Example, as shown in Table 37, if what formed beforehand directly the thin film which consists of various crystallized states, such as an amorphous state, a polycrystal, and an orientated polycrystal etc., is used as a substrate, it was confirmed that the single crystal thin film which comprises as the main ingredients at least one or more materials selected from a gallium nitride, an indium nitride, and an aluminum nitride can form on it.

As shown in experiment No. 412, and 419 of Table 20 of Example 19, the thin film formed on the substrate using the sintered compact which comprises an aluminum nitride as the main ingredients and added Li₂CO₃ of 25 volume % by Li₂O conversion and Si of 25 volume % by SiO₂ conversion is a polycrystalline substance whose diffraction peak is shown only from the lattice plane of a Miller Index (002), (101), (102), direct formation of a single crystal thin film was difficult on this substrate.

On the other hand, in this Example, as shown in experiment No. 842-844 and experiment No. 851-853 of Table 37, even if it uses the substrate which consists of the same sintered compact, when beforehand forming the AlN thin film of an amorphous state, a polycrystal, and an orientated polycrystal, it was confirmed that the single crystal thin film of excellent crystallinity can be easily formed on it.

As shown in experiment No. 861 of Table 37 in this Example, although direct formation of a single crystal thin film was difficult on the sintered compact which comprises an aluminum nitride as the main ingredients and added SiO₂ 50 volume %, as shown in experiment No. 862-864, even if it uses the same substrate, when beforehand forming the AlN thin film of an amorphous state, a polycrystal, and an orientated polycrystal, it was confirmed that the single crystal thin film of excellent crystallinity can be easily formed on it.

The example using the substrate which consists of a sintered compact which comprises an aluminum nitride as the main ingredients and added each transition metal ingredient of Mo, W, V, Nb, Ta, and Ti and carbon as an additive is shown in Table 38.

In Table 38, except for the substrate consisting of a sintered compact which was used in experiment No. 884-887 and which was produced by adding W 75 volume % by element conversion and comprises an aluminum nitride as the main ingredients, all the substrates which consist of a sintered compact which was produced in Example 19 and which is indicated in Table 21 and comprises an aluminum nitride as the main ingredients are used as they are.

As shown in each experiment of Table 38, in all the substrates which consist of a sintered compact which comprises an aluminum nitride as the main ingredients and formed beforehand the thin film which consists of various crystallized states, such as an amorphous state, a polycrystal, an orientated polycrystal, and a single crystal etc., the single crystal thin film which comprises as the main ingredients at least one or more materials selected from a gallium nitride, an indium nitride, and an aluminum nitride has been formed on these.

This single crystal thin film was what has the crystallinity not more than 300 seconds as half width of the rocking curve of the lattice plane of a Miller Index (002).

It has confirmed that the crystallinity of this single crystal thin film improved than what was formed directly on the substrate which consists of a same sintered compact which comprises an aluminum nitride as the main ingredients.

When what formed beforehand the thin film which consists of various crystallized states, such as an amorphous state, a polycrystal, an orientated polycrystal, and a single crystal etc., on the substrate which consists of a sintered compact which comprises an aluminum nitride as the main ingredients and is shown in Table 38 of this Example is used, as for the single crystal thin film formed on it, though the half width of the rocking curve of the lattice plane of the Miller Index (002) of this single crystal thin film was not less than 100 seconds in many in the substrates which contain at least one or more ingredients selected from each transition metal ingredient of Mo, W, V, Nb, Ta, and Ti, and carbon not less than 50 volume % by element conversion, it was not more than 100 seconds in many in the other substrates, i.e., in what contains at least one or more ingredients selected from each transition metal ingredient of Mo, W, V, Nb, Ta, and Ti, and carbon not more than 50 volume % by element conversion.

As for the substrate which consists of a sintered compact which comprises an aluminum nitride as the main ingredients and contains the compound containing each transition metal ingredient of Mo, W, V, Nb, Ta, and Ti and carbon as an additive, even if it is what cannot directly form a single crystal thin film on it, in this Example, as shown in Table 38, if what formed beforehand directly the thin film which consists of various crystallized states, such as an amorphous state, a polycrystal, and an orientated polycrystal etc., is used as a substrate, it was confirmed that the single crystal thin film which comprises as the main ingredients at least one or more materials selected from a gallium nitride, an indium nitride, and an aluminum nitride can form on it.

As shown in experiment No. 431, and 435 of Table 21 of Example 19, the thin film formed on the substrate using the sintered compact which comprises an aluminum nitride as the main ingredients and added Mo of 55 volume % by element conversion and W of 55 volume % by element conversion is a polycrystalline substance whose diffraction peak is shown only from the lattice plane of a Miller Index (002), (101), (102), direct formation of a single crystal thin film was difficult on this substrate.

On the other hand, in this Example, as shown in experiment No. 875-877, and experiment No. 881-883 of Table 38, even if it uses the substrate which consists of the same sintered compact, when beforehand forming the AlN thin film of an amorphous state, a polycrystal, and an orientated polycrystal, it was confirmed that the single crystal thin film of excellent crystallinity can be easily formed on it.

Furthermore, as shown in experiment No. 884 of Table 38 in this Example, the thin film formed on the substrate using the sintered compact which comprises an aluminum nitride as the main ingredients and added W 75 volume % is a polycrystalline substance whose diffraction peak is shown only from the lattice plane of a Miller Index (002), (101), (102), and direct formation of a single crystal thin film was difficult on this substrate.

On the other hand, as shown in experiment No. 885-887, even if it uses the same substrate which consists of a sintered compact, when beforehand forming the AlN thin film of an amorphous state, a polycrystal, and an orientated polycrystal, it was confirmed that the single crystal thin film of excellent crystallinity can be easily formed on it.

The example using the substrate which consists of a sintered compact which added each transition metal ingredient of Mo, W, and V and carbon and which added further at least one or more of a rare earth element and alkaline-earth-metals ingredient as an additive and comprises an aluminum nitride as the main ingredients is shown in Table 39.

In Table 39, except for the substrate consisting of a sintered compact which was used in experiment No. 913-916 and which was produced by adding together W 60 volume % by element conversion and Er₂O₃ 3.6 volume % by oxide conversion and comprises an aluminum nitride as the main ingredients, all the substrates which consist of a sintered compact which was produced in Example 19 and which is indicated in Table 22 and comprises an aluminum nitride as the main ingredients are used as they are.

As shown in each experiment of Table 39, in all the substrates which consist of a sintered compact which comprises an aluminum nitride as the main ingredients and formed beforehand the thin film which consists of various crystallized states, such as an amorphous state, a polycrystal, an orientated polycrystal, and a single crystal etc., the single crystal thin film which comprises as the main ingredients at least one or more materials selected from a gallium nitride, an indium nitride, and an aluminum nitride has been formed on these.

This single crystal thin film was what has the crystallinity not more than 300 seconds as half width of the rocking curve of the lattice plane of a Miller Index (002).

It has confirmed that the crystallinity of this single crystal thin film improved than what formed directly on the substrate which consists of a same sintered compact which comprises an aluminum nitride as the main ingredients.

When what formed beforehand the thin film which consists of various crystallized states, such as an amorphous state, a polycrystal, an orientated polycrystal, and a single crystal etc., on the substrate which consists of a sintered compact which comprises an aluminum nitride as the main ingredients and was shown in Table 39 of this Example is used, as for the single crystal thin film formed on these, when the content of each transition metal ingredient of Mo, W, and V and carbon is calculated by element conversion and the content of a rare earth element and alkaline-earth-metals ingredient is calculated by oxide conversion, though the half width of the rocking curve of the lattice plane of the Miller Index (002) of this single crystal thin film was not less than 100 seconds in the substrates which contain these a total of not less than 50 volume %, in the substrates which contain the above-mentioned ingredient a total of not more than 50 volume % it was not more than 100 seconds in many things.

As for the substrate which consists of a sintered compact which comprises an aluminum nitride as the main ingredients and which contains together the compound containing each transition metal ingredient of Mo, W, V, Nb, Ta, and Ti and carbon and the compound containing at least one or more among a rare earth element and alkaline-earth-metals ingredient, even if it is what cannot form directly a single crystal thin film on it, in this Example, as shown in Table 39, if what formed beforehand directly the thin film which consists of various crystallized states, such as an amorphous state, a polycrystal, and an orientated polycrystal etc., is used as a substrate, it was confirmed that the single crystal thin film which comprises as the main ingredients at least one or more materials selected from a gallium nitride, an indium nitride, and an aluminum nitride can form on it.

As for the thin film formed on the substrate using the sintered compact which comprises an aluminum nitride as the main ingredients and which added together W 60 volume % by element conversion and Er₂O₃ 3.6 volume % by oxide conversion as shown in experiment No. 913 of Table 39 in this Example, it is a polycrystalline substance whose diffraction peak is shown only from the lattice plane of a Miller Index (002), (101), (102), and direct formation of a single crystal thin film was difficult on this substrate.

On the other hand, as shown in experiment No. 914-916, even if it uses the substrate which consists of the same sintered compact, when beforehand forming the AlN thin film of an amorphous state, a polycrystal, and an orientated polycrystal, it was confirmed that the single crystal thin film of excellent crystallinity can be easily formed on it.

The example is shown in Table 40, using the substrate which consists of a sintered compact which comprises an aluminum nitride as the main ingredients and which contains as an additive the compound containing unescapable metal, such as Fe, Ni, Cr, Mn, Zr, Hf, Co, Cu, and Zn, or contains together the compound containing these unescapable metals and at least one or more of a rare earth element compound and an alkaline-earth-metals compound.

In Table 40, except for the substrate consisting of a sintered compact which was used in experiment No. 930-931 and which was produced by adding Fe 72 weight % by element conversion and comprises an aluminum nitride as the main ingredients, all the substrates which consist of a sintered compact which was produced in Example 19 and which is indicated in Table 23 and comprises an aluminum nitride as the main ingredients are used as they are.

As shown in each experiment of Table 40, in all the substrates which consist of a sintered compact which comprises an aluminum nitride as the main ingredients and formed beforehand the thin film which consists of various crystallized states, such as an amorphous state, a polycrystal, an orientated polycrystal, and a single crystal, the single crystal thin film which comprises as the main ingredients at least one or more materials selected from a gallium nitride, an indium nitride, and an aluminum nitride has been formed on these.

This single crystal thin film was what has the crystallinity not more than 300 seconds as half width of the rocking curve of the lattice plane of a Miller Index (002).

It has confirmed that the crystallinity of this single crystal thin film improved than what formed directly on the substrate which consists of a same sintered compact which comprises an aluminum nitride as the main ingredients.

When what formed beforehand the thin film which consists of various crystallized states, such as an amorphous state, a polycrystal, an orientated polycrystal, and a single crystal etc., on the substrate which consists of a sintered compact which comprises an aluminum nitride as the main ingredients and was shown in Table 40 of this Example is used, as for the single crystal thin film formed on it, though the half width of the rocking curve of the lattice plane of the Miller Index (002) of this single crystal thin film was not less than 100 seconds in many in the substrates which contain at least one or more ingredients selected from Fe, Ni, Cr, Mn, Zr, Hf, Co, Cu, and Zn not less than 50 weight % by element conversion, it was not more than 100 seconds in the other substrates which contain at least one or more ingredients selected from Fe, Ni, Cr, Mn, Zr, Hf, Co, Cu, and Zn not more than 50 weight % by element conversion.

As for the substrate which consists of a sintered compact which comprises an aluminum nitride as the main ingredients and contains unescapable metallic compounds, such as Fe, nickel, Cr, Mn, Zr, Hf, Co, Cu, and Zn, as an additive, even if it is what cannot directly form a single crystal thin film on it, in this Example, as shown in Table 40, if what formed beforehand directly the thin film which consists of various crystallized states, such as an amorphous state, a polycrystal, and an orientated polycrystal, etc, is used as a substrate, it was confirmed that the single crystal thin film which comprises as the main ingredients at least one or more materials selected from a gallium nitride, an indium nitride, and an aluminum nitride can form on it.

As shown in experiment No. 462 of Table 23 of Example 19, as for the thin film formed on the substrate using the sintered compact which comprises an aluminum nitride as the main ingredients and which added Fe 55 weight % by element conversion, it is a polycrystalline substance whose diffraction peak is shown only from the lattice plane of a Miller Index (002), (101), (102), direct formation of a single crystal thin film was difficult on this substrate.

On the other hand, in this Example, as shown in experiment No. 927-929 of Table 40, even if it used the substrate which consists of the same sintered compact, when beforehand forming the AlN thin film of an amorphous state, a polycrystal, and an orientated polycrystal, it was confirmed that the single crystal thin film of excellent crystallinity can be easily formed on it.

Furthermore, as shown in experiment No. 930 of Table 40 in this Example, as for the thin film formed on the substrate using the sintered compact which comprises an aluminum nitride as the main ingredients and which added Fe 72 weight %, it is a polycrystalline substance whose diffraction peak is shown only from the lattice plane of a Miller Index (002), (101), (102), and direct formation of a single crystal thin film was difficult on this substrate.

On the other hand, as shown in experiment No. 93 1, even if it uses the substrate which consists of the same sintered compact, if beforehand forming the AlN orientated polycrystalline thin film, it was confirmed that the single crystal thin film of excellent crystallinity can be easily formed on it.

In this Example, though the appearance of all the thin films produced in the experiment indicated in Table 35, Table 36, Table 37, Table 38, Table 39, and Table 40 was investigated, defects, such as a crack and a crevice, are not seen altogether in the thin film formed beforehand on the substrate and in the thin film which is formed furthermore on it.

Although the exfoliation test by pressure sensitive adhesive tape was performed, in all the thin films, exfoliation was not seen between the substrates which consist of a sintered compact which comprises an aluminum nitride as the main ingredients, and between thin films.

Although the thin film conductivity material of Ti/Pt/Au was formed on the thin film of the surface of a substrate, the metal lead was soldered and perpendicular tensile strength was investigated, it all is not less than 2 Kg/mm², so it has joined firmly between the sintered compact which comprises an aluminum nitride as the main ingredients and the thin film formed beforehand on the substrate, and between this thin film and the thin film formed furthermore on it.

### EXAMPLE 27

This Example shows the example which tried formation of the single crystal thin film which comprises as the main ingredients at least one or more materials selected from a gallium nitride, an indium nitride, and an aluminum nitride on the substrate in which these thin films were formed furthermore, after beforehand forming a single crystal thin film, an amorphous thin film, a polycrystalline thin film, and an orientated polycrystalline thin film which comprises as the main ingredients at least one or more materials selected from a gallium nitride, an indium nitride, and an aluminum nitride by the MOCVD method, the sputtering method, and the ion-plating method onto these substrates using as a substrate the sintered compact which comprises as the main ingredients a silicon carbide, a silicon nitride, a zinc oxide, a beryllium oxide, and an aluminum oxide.

First, the substrate which consists of a sintered compact which was produced in Example 1 and comprises as the main ingredients a silicon carbide, a silicon nitride, a zinc oxide, a beryllium oxide, and an aluminum oxide was prepared.

Mirror surface polishing by the same method as Example 8 and Example 9 is given, and ultrasonic washing of these substrate surfaces has been carried out with methylene chloride.

Next, after choosing a part of substrates which were prepared like that, the thin film of 100 mol % AlN was formed beforehand on it in the thickness of 3 μm by the same conditions as the sputtering method performed in experiment No. 706, 707, and 708 and the MOCVD method performed in experiment No. 709 of Example 25.

Furthermore, the thin film of 100 mol % GaN was formed beforehand in the thickness of 3 μm by the same conditions as the MOCVD method performed in experiment No. 714, 728, 729, and 730, and the thin film of 100 mol % InN was formed beforehand in the thickness of 3 μm by the same conditions as the MOCVD method performed in experiment No. 715 and 731.

Next, the thin films of each composition of the same 100 mol % AlN, 100 mol % GaN, 100 mol % InN, 50 mol % AlN+50 mol % GaN, and 50 mol % GaN+50 mol % InN as what was described in Example 19 were formed furthermore on it in the thickness of 3 gm by the MOCVD method, using the above mentioned substrate which formed beforehand AlN thin film, GaN thin film, and InN thin film and the substrate which was left without forming an AlN thin film.

As conditions of MOCVD as described in Example 19 they were the same conditions as Example 1 and Example 2.

The characteristic of the thin film produced like that was shown in Table 41 and 42.

In Table 41, the example using AlN as a thin film formed beforehand is indicated.

In Table 42, the example using GaN and InN as a thin film formed beforehand is indicated.

As shown in Table 41, as for the GaN thin film formed beforehand by the MOCVD method directly on the substrate which consists of a sintered compact which comprises as the main ingredients a silicon carbide, a silicon nitride, a zinc oxide, a beryllium oxide, and an aluminum oxide, what corresponded to the crystallized state of the AlN thin film formed in experiment No. 706, 707, 708, and 709 of Example 25 was formed like the sintered compact which comprises an aluminum nitride as the main ingredients.

That is, the AlN thin films of experiment No. 948, 959, 966, and 977 which were formed by the sputtering method of the same condition as experiment No. 706 were amorphous, and the AlN thin films of experiment No. 949, 967, and 978 which were formed by the sputtering method of the same condition as experiment No. 707 were a polycrystal whose diffraction lines have appeared only from a lattice plane of a Miller Index (002), (101), (102).

As for the AlN thin film formed by the sputtering method of the same conditions as experiment No. 708, only the diffraction line from the lattice plane of a Miller Index (002) has appeared, it was the orientated polycrystal formed in the direction where C axis is perpendicular to the substrate surface.

As for the AlN thin films of experiment No. 951, 969, 980, and 989 which were formed by the MOCVD method of the same conditions as experiment No. 709, only the diffraction line from the lattice plane of a Miller Index (002) has appeared, it was confirmed that they are the single crystal formed in the direction where C axis is perpendicular to the substrate surface.

In Table 41, the half width of the rocking curve of the X ray diffraction line from the lattice plane of the Miller Index (002) of the thin film formed in the state of the orientated polycrystal and the single crystal among the thin films formed beforehand in these substrates is indicated.

Next, the crystallinity of the thin film which consists of the above-mentioned each composition of 100 mol % AlN, 100 mol % GaN, 100 mol % InN, 50 mol % AlN+50 mol % GaN, and 50 mol % GaN+50 mol % InN which were formed by the MOCVD method on the substrate which formed beforehand the AlN thin film of various crystallized states and the substrate which consists of a sintered compact on which an AlN thin film is not being formed and which comprises as the main ingredients a silicon carbide, a silicon nitride, a zinc oxide, a beryllium oxide, and an aluminum oxide was investigated by X ray diffraction.

Consequently, it was confirmed that all the produced thin films are the single crystal formed in the direction where C axis is perpendicular to the substrate surface.

If the crystallinity is seen, while the half width of the rocking curve of the X ray diffraction line from the lattice plane of the Miller Index (002) of AlN, GaN, and an InN single crystal thin film which were formed directly on the substrate without beforehand forming an AlN thin film on the substrate which consists of a sintered compact which comprises as the main ingredients a silicon carbide, a silicon nitride, a zinc oxide, a beryllium oxide, and an aluminum oxide is not less than 240 seconds altogether, it is not more than 200 seconds altogether in the case of AlN, GaN, and an InN single crystal thin film which were formed furthermore on the AlN thin film formed beforehand on the above-mentioned substrate which comprises various ceramics as the main ingredients, it was confirmed that the single crystal thin film of excellent crystallinity is obtained clearly.

In each sintered compact, if the crystallized state of the AlN thin film formed beforehand is an orientated polycrystal, it was shown that the single crystal formed on it has the tendency which is easy to form what was more excellent crystallinity than what is a single crystal, an amorphous state, and a polycrystal.

Based on the experimental result shown in Table 41, it states in detail below.

While the half width of the rocking curve of the X ray diffraction line from the lattice plane of the Miller Index (002) of the single crystal thin film directly formed on the substrate which consists of a sintered compact which comprises a silicon carbide as the main ingredients is in the range of 255 seconds-283 seconds, it is in the range of 139 seconds-192 seconds in the case of the single crystal thin film formed on the substrate which formed beforehand the AlN thin film, so the single crystal thin film whose crystallinity improved clearly is obtained.

While the half width of the rocking curve of the X ray diffraction line from the lattice plane of the Miller Index (002) of the single crystal thin film formed on it is in the range of 169 seconds-192 seconds when the AlN thin film formed beforehand is the crystallized state of an amorphous state, a polycrystal, and a single crystal, it is in the range of 139 seconds-147 seconds in the case of what is the crystallized state of an orientated polycrystal, so single crystal thin film whose crystallinity improved more is obtained.

While the half width of the rocking curve of the X ray diffraction line from the lattice plane of the Miller Index (002) of the single crystal thin film directly formed on the substrate which consists of a sintered compact which comprises a silicon nitride as the main ingredients is the range of 493 seconds-647 seconds, it is in the range of 163 seconds-188 seconds in the case of the single crystal thin film formed on the substrate which formed beforehand the AlN thin film, so the single crystal thin film whose crystallinity improved clearly is obtained.

While the half width of the rocking curve of the X ray diffraction line from the lattice plane of the Miller Index (002) of the single crystal thin film formed on it is 188 seconds when the AlN thin film formed beforehand is the crystallized state of an amorphous state, it is in the range of 163 seconds-167 seconds in the case of what is the crystallized state of an orientated polycrystal, so the single crystal thin film whose crystallinity improved more is obtained.

While the half width of the rocking curve of the X ray diffraction line from the lattice plane of the Miller Index (002) of the single crystal thin film directly formed on the substrate which consists of a sintered compact which comprises an aluminum oxide as the main ingredients is in the range of 377 seconds-426 seconds, it is in the range of 155 seconds-195 seconds in the case of the single crystal thin film formed on the substrate which formed beforehand the AlN thin film, so the single crystal thin film whose crystallinity improved clearly is obtained.

While the half width of the rocking curve of the X ray diffraction line from the lattice plane of the Miller Index (002) of the single crystal thin film formed on it is in the range of 169 seconds-195 seconds when the AlN thin film formed beforehand is the crystallized state of an amorphous state, a polycrystal, and a single crystal, it is in the range of 155 seconds-163 seconds in the case of what is the crystallized state of an orientated polycrystal, so the single crystal thin film whose crystallinity improved more is obtained.

While the half width of the rocking curve of the X ray diffraction line from the lattice plane of the Miller Index (002) of the single crystal thin film directly formed on the substrate which consists of a sintered compact which comprises a zinc oxide as the main ingredients is the range of 258 seconds-291 seconds, it is in the range of 136 seconds-196 seconds in the case of the single crystal thin film formed on the substrate which formed beforehand the AlN thin film, so the single crystal thin film whose crystallinity improved clearly is obtained.

While the half width of the rocking curve of the X ray diffraction line from the lattice plane of the Miller Index (002) of the single crystal thin film formed on it is in the range of 182 seconds-196 seconds when the AlN thin film formed beforehand is the crystallized state of an amorphous state, a polycrystal, and a single crystal, it is in the range of 136 seconds-144 seconds in the case of what is the crystallized state of an orientated polycrystal, so the single crystal thin film whose crystallinity improved more is obtained.

While the half width of the rocking curve of the X ray diffraction line from the lattice plane of the Miller Index (002) of the single crystal thin film directly formed on the substrate which consists of a sintered compact which comprises a beryllium oxide as the main ingredients is in the range of 268 seconds-290 seconds, it is in the range of 137 seconds-192 seconds in the case of the single crystal thin film formed on the substrate which formed beforehand the AlN thin film, so the single crystal thin film whose crystallinity improved clearly is obtained.

While the half width of the rocking curve of the X ray diffraction line from the lattice plane of the Miller Index (002) of the single crystal thin film formed on it is 202 seconds when the AlN thin film formed beforehand is the crystallized state of a single crystal, it is in the range of 136 seconds-144 seconds in the case of what is the crystallized state of an orientated polycrystal, the single crystal thin film whose crystallinity improved more is obtained.

As shown in Table 42, as for the GaN thin film formed beforehand by the MOCVD method directly on the substrate which consists of a sintered compact which comprises as the main ingredients a silicon carbide, a silicon nitride, a zinc oxide, a beryllium oxide, and an aluminum oxide, what corresponded to the crystallized state of the AlN thin film formed in experiment No. 714, 728, 729, and 730 of Example 25 was formed like the sintered compact which comprises an aluminum nitride as the main ingredients.

And, as for the InN thin film formed beforehand directly by the MOCVD method, as shown in Table 42, what corresponded to the crystallized state of the InN thin film which was formed in experiment No. 715 and 731 of Example 25 was formed.

That is, the GaN thin films of experiment No. 994, 1003, 1010, 1019, and 1028 which were formed by the MOCVD method of the same condition as experiment No. 728 were amorphous, and the GaN thin films of experiment No. 995, 1004, 1011, 1020, and 1029 which were formed by the MOCVD method of the same condition as experiment No. 729 were the polycrystal whose diffraction lines have appeared only from the lattice plane of a Miller Index (002), (101).

As for the GaN thin film formed by the MOCVD method of the same conditions as experiment No. 730, only the diffraction line from the lattice plane of a Miller Index (002) has appeared, it was the orientated polycrystal formed in the direction where C axis is perpendicular to the substrate surface.

As for the GaN thin films of experiment No. 997, 1006, 1013, 1022, and 1031 which were formed by the MOCVD method of the same conditions as experiment No. 714, only the diffraction line from the lattice plane of a Miller Index (002) has appeared, it was confirmed that it is the single crystal formed in the direction where C axis is perpendicular to the substrate surface.

As for the InN thin film of experiment No. 1001, 1008, 1017, 1026, and 1035 which were formed by the MOCVD method of the same conditions as experiment No. 731, only the diffraction line from the lattice plane of a Miller Index (002) has appeared, it was the orientated polycrystal formed in the direction where C axis is perpendicular to the substrate surface.

As for the InN thin film of experiment No. 1002, 1009, 1018, 1027, and 1036 which were formed by the MOCVD method of the same conditions as experiment No. 715, only the diffraction line from the lattice plane of a Miller Index (002) has appeared, it was confirmed that it is the single crystal formed in the direction where C axis is perpendicular to the substrate surface.

As mentioned above, in Table 42, the crystallized state identified by X ray diffraction of the thin film formed beforehand directly on these substrates which consist of a sintered compact which comprises as the main ingredients a silicon carbide, a silicon nitride, a zinc oxide, a beryllium oxide, and an aluminum oxide is shown.

The half width of the rocking curve of the X ray diffraction line from the lattice plane of the Miller Index (002) of the thin film identified as an orientated polycrystal and a single crystal among these thin films is indicated.

Next, the crystallinity of the thin film which consists of the above-mentioned each composition of 100 mol % AlN, 100 mol % GaN, 100 mol % InN, 50 mol % AlN+50 mol % GaN, and 50 mol % GaN+50 mol % InN which were formed by the MOCVD method on the substrate which formed beforehand the GaN thin film and InN thin film of various crystallized states and the substrate which consists of a sintered compact on which a GaN thin film and an InN thin film are not being formed and which comprises as the main ingredients a silicon carbide, a silicon nitride, a zinc oxide, a beryllium oxide, and an aluminum oxide was investigated by Xray diffraction.

Consequently, it was confirmed that all the produced thin films are the single crystal formed in the direction where C axis is perpendicular to the substrate surface.

If the crystallinity is seen, as shown in Table 42, while the half width of the rocking curve of the X ray diffraction line from the lattice plane of the Miller Index (002) of AlN, GaN, and an InN single crystal thin film which were formed directly on the substrate without beforehand forming the GaN thin film and InN thin film on the substrate which consists of a sintered compact which comprises as the main ingredients a silicon carbide, a silicon nitride, a zinc oxide, a beryllium oxide, and an aluminum oxide is not less than 240 seconds altogether, it is not more than 200 seconds altogether in the case of AlN, GaN, and an InN single crystal thin film which were formed furthermore on the GaN thin film and InN thin film which were formed beforehand on the substrate which comprises various ceramics as the main ingredients, it was confirmed that the single crystal thin film of excellent crystallinity is obtained clearly.

In each sintered compact, if the crystallized state of the GaN thin film and InN thin film formed beforehand is an orientated polycrystal, it was shown that the single crystal formed on it has the tendency which is easy to form what was more excellent crystallinity than what is a single crystal, an amorphous state, and a polycrystal.

Based on the result shown in Table 42, it states to details below.

While the half width of the rocking curve of the X ray diffraction line from the lattice plane of the Miller Index (002) of the single crystal thin film directly formed on the substrate which consists of a sintered compact which comprises a silicon carbide as the main ingredients is in the range of 255 seconds-283 seconds, it is in the range of 137 seconds-189 seconds in the case of the single crystal thin film formed on the substrate which formed beforehand the GaN thin film or the InN thin film, so the single crystal thin film whose crystallinity improved clearly is obtained.

While the half width of the rocking curve of the X ray diffraction line from the lattice plane of the Miller Index (002) of the single crystal thin film formed on it is in the range of 165 seconds-189 seconds when the GaN thin film or the InN thin film formed beforehand is the crystallized state of an amorphous state, a polycrystal, and a single crystal, it is in the range of 137 seconds-146 seconds in the case of what is the crystallized state of an orientated polycrystal, so the single crystal thin film whose crystallinity improved more is obtained.

While the half width of the rocking curve of the X ray diffraction line from the lattice plane of the Miller Index (002) of the single crystal thin film directly formed on the substrate which consists of a sintered compact which comprises a silicon nitride as the main ingredients is in the range of 493 seconds-647 seconds, it is in the range of 141 seconds-189 seconds in the case of the single crystal thin film formed on the substrate which formed beforehand the GaN thin film or the InN thin film, so the single crystal thin film whose crystallinity improved clearly is obtained.

While the half width of the rocking curve of the X ray diffraction line from the lattice plane of the Miller Index (002) of the single crystal thin film formed on it is in the range of 169 seconds-189 seconds when the GaN thin film or the InN thin film formed beforehand is the crystallized state of an amorphous state, a polycrystal, and a single crystal, it is in the range of 161 seconds-167 seconds in the case of what is the crystallized state of an orientated polycrystal, so the single crystal thin film whose crystallinity improved more is obtained.

While the half width of the rocking curve of the X ray diffraction line from the lattice plane of the Miller Index (002) of the single crystal thin film directly formed on the substrate which consists of a sintered compact which comprises an aluminum oxide as the main ingredients is in the range of 377 seconds-426 seconds, it is in the range of 154 seconds-190 seconds in the case of the single crystal thin film formed on the substrate which formed beforehand the GaN thin film or the InN thin film, so the single crystal thin film whose crystallinity improved clearly is obtained.

While the half width of the rocking curve of the X ray diffraction line from the lattice plane of the Miller Index (002) of the single crystal thin film formed on it is in the range of 170 seconds-190 seconds when the GaN thin film or the InN thin film formed beforehand is the crystallized state of an amorphous state, a polycrystal, and a single crystal, it is in the range of 154 seconds-165 seconds in the case of what is the crystallized state of an orientated polycrystal, so the single crystal thin film whose crystallinity improved more is obtained.

While the half width of the rocking curve of the X ray diffraction line from the lattice plane of the Miller Index (002) of the single crystal thin film directly formed on the substrate which consists of a sintered compact which comprises a zinc oxide as the main ingredients is in the range of 258 seconds-291 seconds, it is in the range of 136 seconds-192 seconds in the case of the single crystal thin film formed on the substrate which formed beforehand the GaN thin film or the InN thin film, so the single crystal thin film whose crystallinity improved clearly is obtained.

While the half width of the rocking curve of the X ray diffraction line from the lattice plane of the Miller Index (002) of the single crystal thin film formed on it is in the range of 157 seconds-192 seconds when the GaN thin film or the InN thin film formed beforehand is the crystallized state of an amorphous state, a polycrystal, and a single crystal, it is in the range of 137 seconds-146 seconds in the case of what is the crystallized state of an orientated polycrystal, so the single crystal thin film whose crystallinity improved more is obtained.

While the half width of the rocking curve of the X ray diffraction line from the lattice plane of the Miller Index (002) of the single crystal thin film directly formed on the substrate which consists of a sintered compact which comprises a beryllium oxide as the main ingredients is in the range of 268 seconds-290 seconds, it is in the range of 138 seconds-190 seconds in the case of the single crystal thin film formed on the substrate which formed beforehand the GaN thin film or the InN thin film, so the single crystal thin film whose crystallinity improved clearly is obtained.

While the half width of the rocking curve of the X ray diffraction line from the lattice plane of the Miller Index (002) of the single crystal thin film formed on it is in the range of 160 seconds-190 seconds when the GaN thin film or the InN thin film formed beforehand is the crystallized state of an amorphous state, a polycrystal, and a single crystal, it is in the range of 138 seconds-147 seconds when it is what is the crystallized state of an orientated polycrystal, so the single crystal thin film whose crystallinity improved is obtained.

In this Example, although the appearance of all the thin films produced in the experiment indicated in Table 41 and Table 42 was investigated, defects, such as a crack and a crevice, are not seen in all the thin films formed beforehand on the substrate and the thin films formed furthermore on it.

Although the exfoliation test by pressure sensitive adhesive tape was performed, in all thin films, exfoliation was not seen between the substrates which consist of a sintered compact which comprises an aluminum nitride as the main ingredients, and between thin films.

Although the thin film conductivity material of Ti/Pt/Au was formed on the thin film of the surface of a substrate, the metal lead was soldered and perpendicular tensile strength was investigated, it all is not less than 2 Kg/mm², so it has joined firmly between the sintered compact which comprises an aluminum nitride as the main ingredients and the thin film formed beforehand on the substrate, and between this thin film and the thin film formed furthermore on it.

### EXAMPLE 28

This Example shows the example which investigated the influence in which the surface smooth nature of these substrates and the layer constitution of a thin film which is formed on it and comprises as the main ingredients a gallium nitride, an indium nitride, and an aluminum nitride gives to the crystallinity of these thin films by using as a substrate the sintered compact which comprises as the main ingredients a silicon carbide, a silicon nitride, a zinc oxide, a beryllium oxide, and an aluminum oxide.

First, the substrates which were produced in Example 1 and which consist of a sintered compact which comprises as the main ingredients a silicon carbide, a silicon nitride, a zinc oxide, a beryllium oxide, and an aluminum oxide were prepared.

Mirror surface polishing by the same method as Example 8 and Example 9 is given, and ultrasonic washing of these substrate surfaces has been carried out with methylene chloride.

In addition, the substrate which carried out specular surface polish using as an abradant the following respectively and using the commercial pad made of cloth as polisher was also newly prepared.

Namely, what carried out specular surface polish of the substrate which consists of a sintered compact which comprises an aluminum oxide as the main ingredients using the abradant which comprises as the main ingredients a colloidal alumina of particle diameter of 0.05 μm, what carried out specular surface polish of the substrate which consists of a sintered compact which comprises a zinc oxide as the main ingredients using the abradant which comprises as the main ingredients a cerium oxide of 0.05 μm of particle diameter, what carried out specular surface polish of the substrate which consists of a sintered compact which comprises a beryllium oxide as the main ingredients using the abradant which comprises as the main ingredients a colloidal silicon oxide of 0.02 μm of particle diameter, were also newly prepared.

Next, the thin film was formed by the same method as what was shown in Example 27 on above prepared each substrate from which the surface smooth nature differs.

That is, the thin film of 100 mol % AlN was formed beforehand in the thickness of 3 μm on the prepared substrate by the same conditions as the sputtering method performed in experiment No. 706, 707 and 708 and as the MOCVD method performed in experiment No. 709 and 721 of

### EXAMPLE 25

The thin film of 100 mol % GaN was formed beforehand in the thickness of 3 gm by the same conditions as the MOCVD method performed in experiment No. 730, and the thin film of 100 mol % InN was formed beforehand in the thickness of 3 μm by the same conditions as the MOCVD method performed in experiment No. 731.

Next, by using the substrate on which the AlN thin film, the GaN thin film, and the InN thin film were formed beforehand as mentioned above, the thin film of each composition of same 100 mol % AlN, 100 mol % GaN, 100 mol % InN, 50 mol % AlN+50 mol % GaN, 50 mol % GaN+50 mol % InN as what was described in Example 19, was formed furthermore on it in the thickness of 3 μm by the MOCVD method.

As conditions of MOCVD, they were the same conditions as Example 1 and Example 2, as described in Example 19.

The above experimental result was collectively shown in Table 43.

That is, as for the average surface roughness Ra of the substrate which has the specular surface polish side and which was newly produced in this Example and consists of a sintered compact comprising an aluminum oxide as the main ingredients, a sintered compact comprising a zinc oxide as the main ingredients, and a sintered compact comprising a beryllium oxide as the main ingredients, respectively, it is shown that it is 7.3 nm, 2.6 nm, and 3.7 nm, respectively in Table 43.

In this Example, as for the 100 mol % AlN thin film formed beforehand directly on the substrate, what corresponded to the crystallized state of the AlN thin film produced in experiment No. 706, 707, 708, 709, and 721 of Example 25 was formed.

That is, the AlN thin film formed by the sputtering method of the same condition as experiment No. 706 was amorphous, and the AlN thin film formed by the sputtering method of the same condition as experiment No. 707 was the polycrystal whose diffraction lines have appeared only from the lattice plane of a Miller Index (002), (101), (102).

As for the AlN thin film formed by the sputtering method of the same conditions as experiment No. 708, only the diffraction line from the lattice plane of a Miller Index (002) has appeared, it was the orientated polycrystal formed in the direction where C axis is perpendicular to the substrate surface.

As for the AlN thin film formed by the MOCVD method of the same conditions as experiment No. 709, only the diffraction line from the lattice plane of a Miller Index (002) has appeared, it was confirmed that it is the single crystal formed in the direction where C axis is perpendicular to the substrate surface.

As for the AlN thin film formed by the MOCVD method of the same conditions as experiment No. 721, only the diffraction line from the lattice plane of a Miller Index (002) has appeared, it is the orientated polycrystal formed in the direction where C axis is perpendicular to the substrate surface, crystallinity has been improved than the thing of experiment No. 708 which showed the crystallized state of the same orientated polycrystal.

As for the 100 mol % GaN thin film formed beforehand directly on the substrate, what corresponded to the crystallized state of the GaN thin film which produced in experiment No. 730 of Example 25 was formed.

That is, in the GaN thin film formed by the MOCVD method of the same conditions as experiment No. 730, only the diffraction line from the lattice plane of a Miller Index (002) had appeared, it was the orientated polycrystal formed in the direction where C axis is perpendicular to the substrate surface.

As for the 100 mol % InN thin film formed beforehand directly on the substrates what corresponded to the crystallized state of the InN thin film which was produced in experiment No. 731 of Example 25 was formed.

That is, in the InN thin film formed by the MOCVD method of the same conditions as experiment No. 731, only the diffraction line from the lattice plane of a Miller Index (002) had appeared, it was the orientated polycrystal formed in the direction where C axis is perpendicular to the substrate surface.

Although the crystallized state identified by X ray diffraction of the thin film formed beforehand on these substrates is shown in Table 43, the half width of the rocking curve of the X ray diffraction line from the lattice plane of the Miller Index (002) of the thin film identified as an orientated polycrystal and a single crystal in it is indicated.

Next, the crystallinity of the thin film which consists of the above-mentioned each composition of 100 mol % AlN, 100 mol % GaN, 100 mol % InN, 50 mol % AlN+50 mol % GaN, and 50 mol % GaN+50 mol % InN which were formed by the MOCVD method on the substrate which consists of a sintered compact which comprises as the main ingredients a silicon carbide, a silicon nitride, a zinc oxide, a beryllium oxide, and an aluminum oxide and which formed beforehand the AlN thin film, GaN thin film, and InN thin film of various crystallized states was investigated by X ray diffraction.

Consequently, it was confirmed that all the produced thin films are the single crystal formed in the direction where C axis is perpendicular to the substrate surface.

If the crystallinity is seen, as shown in Table 43, in all the substrates which consist of a sintered compact which comprise as the main ingredients a silicon carbide, a silicon nitride, a zinc oxide, a beryllium oxide, and an aluminum oxide, it was confirmed that there is a tendency which improves as the average surface roughness Ra becomes small.

Namely, when the substrate whose Ra is a larger than 10 nm was used, even if it is the case where an orientated polycrystalline thin film is formed beforehand, while the half width of the rocking curve of the X ray diffraction line from the lattice plane of the Miller Index (002) of the single crystal thin film formed is larger than 150 seconds, when Ra is not more than 10 nm, if an orientated polycrystalline thin film is formed beforehand, crystallinity improves into not more than 150 seconds, when Ra is not more than 5 nm, if all the thin film formed beforehand has the crystallized state of an amorphous state, a polycrystal, an orientated polycrystal, and a single crystal, it was confirmed that they improve further into not more than 130 seconds.

Based on the result shown in Table 43, it states to details below.

In the case of the substrate which consists of a sintered compact which comprises a silicon carbide as the main ingredients, when the crystallized state of the thin film formed beforehand on the thing whose average surface roughness Ra is 6.8 nm is amorphous, the half width of the rocking curve of the X ray diffraction line from the lattice plane of the Miller Index (002) of the single crystal thin film formed furthermore on it is 165 seconds, and the half width of the rocking curve of the X ray diffraction line from the lattice plane of the Miller Index (002) of the single crystal thin film formed furthermore on the thin film whose crystallized state is an orientated polycrystal is in the range of 139 seconds-145 seconds, when the substrate of which average surface roughness Ra is 2.9 nm was used, the half width of the rocking curve of the X ray diffraction line from the lattice plane of the Miller Index (002) of the single crystal thin film formed furthermore on the amorphous thin film, the polycrystalline thin film, the orientated polycrystalline thin film, and the single crystal thin film, which were formed beforehand, is not more than 130 seconds, so its crystallinity was improving.

Especially the half width of the rocking curve of the X ray diffraction line from the lattice plane of the Miller Index (002) of the single crystal thin film formed furthermore on the orientated polycrystalline thin film formed beforehand was not more than 120 seconds, so it was improving further.

In the case of the substrate which consists of a sintered compact which comprises a silicon nitride as the main ingredients, while the half width of the rocking curve of the X ray diffraction line from the lattice plane of the Miller Index (002) of the single crystal thin film formed furthermore on the amorphous thin film and the orientated polycrystalline thin film which are being formed beforehand on the thing whose average surface roughness Ra is 15 nm is in the range of 169 seconds-189 seconds, when the substrate of which average surface roughness Ra is 4.4 nm was used, the half width of the rocking curve of the X ray diffraction line from the lattice plane of the Miller Index (002) of the single crystal thin film formed furthermore on the amorphous thin film, the polycrystalline thin film, the orientated polycrystalline thin film, and the single crystal thin film, which were formed beforehand, is not more than 130 seconds, so its crystallinity was improving.

Especially the half width of the rocking curve of the X ray diffraction line from the lattice plane of the Miller Index (002) of the single crystal thin film formed furthermore on the orientated polycrystalline thin film formed beforehand was not more than 120 seconds, so it was improving further.

In the case of the substrate which consists of a sintered compact which comprises an aluminum oxide as the main ingredients, while the half width of the rocking curve of the X ray diffraction line from the lattice plane of the Miller Index (002) of the single crystal thin film formed furthermore on the amorphous thin film and the orientated polycrystalline thin film which are being formed beforehand on the thing whose average surface roughness Ra is 11 nm is in the range of 154 seconds-177 seconds, when the substrate whose average surface roughness Ra is 7.3 nm was used, and when the thin film formed beforehand is a crystallized state of an orientated polycrystal, the half width of the rocking curve of the X ray diffraction line from the lattice plane of the Miller Index (002) of the single crystal thin film which was formed furthermore on it is in the range of 135 seconds-140 seconds, so its crystallinity was improving.

When the substrate of which average surface roughness Ra is 1.9 nm was used, the half width of the rocking curve of the X ray diffraction line from the lattice plane of the Miller Index (002) of the single crystal thin film formed furthermore on the amorphous thin film, the polycrystalline thin film, the orientated polycrystalline thin film, and the single crystal thin film, which were formed beforehand, is not more than 130 seconds, so its crystallinity was improving.

Especially the half width of the rocking curve of the X ray diffraction line from the lattice plane of the Miller Index (002) of the single crystal thin film formed furthermore on the orientated polycrystalline thin film formed beforehand was not more than 120 seconds, so it was improving further.

In the case of the substrate which consists of a sintered compact which comprises a zinc oxide as the main ingredients, while the half width of the rocking curve of the X ray diffraction line from the lattice plane of the Miller Index (002) of the single crystal thin film formed furthermore on it is 170 seconds when the crystallized state of the thin film formed beforehand on the thing whose average surface roughness Ra is 6.8 nm is amorphous, and while the half width of the rocking curve of the X ray diffraction line from the lattice plane of the Miller Index (002) of the single crystal thin film formed furthermore on the thin film of which the crystallized state is an orientated polycrystal is in the range of 137 seconds-144 seconds, the half width of the rocking curve of the X ray diffraction line from the lattice plane of the Miller Index (002) of the single crystal thin film formed furthermore on the amorphous thin film, the polycrystalline thin film, the orientated polycrystalline thin film, and the single crystal thin film, which were formed beforehand, is not more than 130 seconds when the substrate of which average surface roughness Ra is 2.6 nm was used, so its crystallinity was improving.

Especially the half width of the rocking curve of the X ray diffraction line from the lattice plane of the Miller Index (002) of the single crystal thin film formed furthermore on the orientated polycrystalline thin film formed beforehand was not more than 120 seconds, so it was improving further.

While the half width of the rocking curve of the X ray diffraction line from the lattice plane of the Miller Index (002) of the single crystal thin film formed furthermore on it is 166 seconds in the case of the substrate which consists of a sintered compact which comprises a beryllium oxide as the main ingredients when the crystallized state of the thin film formed beforehand on the thing whose average surface roughness Ra is 9.4 nm is amorphous, and while the half width of the rocking curve of the X ray diffraction line from the lattice plane of the Miller Index (002) of the single crystal thin film formed furthermore on the thin film of which the crystallized state is an orientated polycrystal is in the range of 138 seconds-141 seconds, the half width of the rocking curve of the X ray diffraction line from the lattice plane of the Miller Index (002) of the single crystal thin film formed furthermore on the amorphous thin film, the polycrystalline thin film, the orientated polycrystalline thin film, and the single crystal thin film, which were formed beforehand, is not more than 130 seconds when the substrate of which average surface roughness Ra is 3.7 nm was used, so its crystallinity was improving.

Especially the half width of the rocking curve of the X ray diffraction line from the lattice plane of the Miller Index (002) of the single crystal thin film formed furthermore on the orientated polycrystalline thin film formed beforehand was not more than 120 seconds, so it was improving further.

While the half width of the rocking curve of the X ray diffraction line from the lattice plane of the Miller Index (002) of the single crystal thin film formed directly is in the range of 268 seconds -290 seconds, it is in the range of 138 seconds-190 seconds in the single crystal thin film formed on the substrate which formed beforehand the GaN thin film or the InN thin film, so the single crystal thin film in which the crystallinity was improved clearly is obtained.

As mentioned above, in this Example, the crystallinity of the single crystal thin film formed furthermore on the substrate which consists of a sintered compact which comprises as the main ingredients a silicon carbide, a silicon nitride, a zinc oxide, a beryllium oxide, and an aluminum oxide and which formed beforehand the AlN thin film, the GaN thin film, and the InN thin film is improved by improvement of the surface smooth nature of the substrate which consists of this sintered compact.

On the other hand, as for an AlN thin film, a GaN thin film, and an InN thin film which are formed beforehand on the substrate consisting of this sintered compact and have the crystallized state of the orientated polycrystal, the crystallinity also improves according to the improvement of the surface smooth nature of a substrate.

That is, as described in Table 43, when the average surface roughness Ra of the substrate which consists of a sintered compact which comprises as the main ingredients a silicon carbide, a silicon nitride, a zinc oxide, a beryllium oxide, and an aluminum oxide is larger than 10 nm, the half width of the rocking curve of the X ray diffraction line from the lattice plane of the Miller Index (002) of an AlN thin film, a GaN thin film, and an InN thin film, which have the crystallized state of the above-mentioned orientated polycrystal formed beforehand on this substrate tends to become larger than 10000 seconds, it was confirmed that the half width of the rocking curve of the X ray diffraction line from the lattice plane of the Miller Index (002) of the single crystal thin film formed on the orientated polycrystalline thin film of such crystallinity has the tendency which is easy to become larger than 150 seconds.

When the average surface roughness Ra of the substrate which consists of a sintered compact which comprises as the main ingredients a silicon carbide, a silicon nitride, a zinc oxide, a beryllium oxide, and an aluminum oxide is not more than 10 nm, the half width of the rocking curve of the X ray diffraction line from the lattice plane of the Miller Index (002) of an AlN thin film, a GaN thin film, and an InN thin film, which have the crystallized state of the above-mentioned orientated polycrystal formed beforehand on this substrate tends to become not more than 10000 seconds, it was confirmed that half width of the rocking curve of the X ray diffraction line from the lattice plane of the Miller Index (002) of the single crystal thin film formed on the orientated polycrystalline thin film of such crystallinity has the tendency in which what is not more than 150 seconds is easy to be formed.

Furthermore, when the average surface roughness Ra of the substrate which consists of a sintered compact which comprises as the main ingredients a silicon carbide, a silicon nitride, a zinc oxide, a beryllium oxide, and an aluminum oxide is not more than 5 nm, what is not more than 8000 seconds can be formed as half width of the rocking curve of the X ray diffraction line from the lattice plane of the Miller Index (002) of an AlN thin film, a GaN thin film, and an InN thin film, which have the crystallized state of the above-mentioned orientated polycrystal formed beforehand on this substrate, it was confirmed that the thing in which the half width of the rocking curve of the X ray diffraction line from the lattice plane of the Miller Index (002) of the single crystal thin film formed on the orientated polycrystalline thin film of such crystallinity is not more than 130 seconds has the tendency easy to be formed.

In this Example, although the appearance of all the thin films produced in the experiment indicated in Table 43 was investigated, in the thin films formed beforehand on the substrate and the thin films formed furthermore on it, defects, such as a crack and a crevice, are not seen altogether.

Although the exfoliation test by pressure sensitive adhesive tape was performed, in all thin films, exfoliation was not seen between the substrates which consist of a sintered compact which comprises as the main ingredients a silicon carbide, a silicon nitride, a zinc oxide, a beryllium oxide, and an aluminum oxide, and between thin films.

Although the thin film conductivity material of Ti/Pt/Au was formed on the thin film of the surface of a substrate, the metal lead was soldered and perpendicular tensile strength was investigated, it all is not less than 2 Kg/mm², so it has joined firmly between the sintered compact which comprises as the main ingredients a silicon carbide, a silicon nitride, a zinc oxide, a beryllium oxide, and an aluminum oxide and the thin film formed beforehand on the substrate, and between this thin film and the thin film formed furthermore on it.

### EXAMPLE 29

This Example shows the example which investigated the influence in which the layer constitution of the thin film which is formed on it and comprises as the main ingredients a gallium nitride, an indium nitride, and an aluminum nitride gives to the crystallinity of the formed thin film by using the thing whose surface smooth nature is comparatively coarse, among the substrate consisting of a sintered compact comprising an aluminum nitride as the main ingredients and the substrate consisting of a sintered compact comprising a silicon carbide, a silicon nitride, a zinc oxide, a beryllium oxide, and an aluminum oxide as the main ingredients.

First, the sintered compact which comprises an aluminum nitride as the main ingredients and was produced in experiment No. 49 of Example 2 was prepared.

In the other, the sintered compacts which were produced in Example 1 and which comprise as the main ingredients a silicon carbide, a silicon nitride, a zinc oxide, a beryllium oxide, and an aluminum oxide were prepared.

A part of these substrates are what has the surface state of an as-fired(as-fire) state and a lap polish state which were used in Example 8.

The thin film formation side of some things among the prepared sintered compacts was in the as-fired state as it is, or was performed a lap polish, or was performed a blast polish, then they were processed further into the diameter of 25.4 mm and the thickness of 0.5 mm, and the substrate for thin film formation was produced.

Among the substrates newly produced in this Example, what has the substrate surface of an as-fired state and lap polish were processed by the same method as Example 8.

That is, in all the substrates which have the surface of an as-fired state, a surface adhesion was removed by brushing using a commercial alumina powder with particle size of 3 μm.

In the substrate to which lap polish was carried out, it was performed using the thing of particle size #240 of SiC in the case of the sintered compact which comprises an aluminum nitride as the main ingredients, it was performed using the thing of particle size #400 of SiC in the case of the sintered compact which comprises an aluminum oxide as the main ingredients, it was performed using the thing of particle size #240 of SiC in the case of the sintered compact which comprises a beryllium oxide as the main ingredients.

Blast polish was performed by a sandblast machine using the thing of particle size #400 of alumina in the case of the sintered compact which comprises an aluminum nitride as the main ingredients, in the case of the sintered compact which comprises a silicon carbide as the main ingredients, it was performed using the thing of particle size #600 of alumina, In the case of the sintered compact which comprises as the main ingredients a silicon nitride, an aluminum oxide, and a zinc oxide, it was performed using the thing of particle size #800 of alumina, in the case of the sintered compact which comprises a beryllium oxide as the main ingredients, it was performed using the thing of particle size #1200 of alumina,

Next, the thin film was formed by the same method as what was shown in Example 25, 26, 27, and 28 to each substrate from which the prepared above-mentioned surface smooth nature differs.

That is, the thin film of 100 mol % AlN was formed beforehand on the prepared substrate by the same conditions as the sputtering method performed in experiment No. 706, 707 and 708 of Example 25, and the MOCVD method performed in experiment No. 709.

The thin film of 100 mol % GaN was formed beforehand according to the same conditions as the MOCVD method performed in experiment No. 730.

Thickness of the thin film formed beforehand on the above-mentioned substrate was set to 6 μm, respectively.

Next, by using the substrate in which the AlN thin film, the GaN thin film, and the InN thin film were formed beforehand as mentioned above, the thin film of each composition of the same 100 mol % AlN, 100 mol % GaN as what was described in Example in Example 19 was formed furthermore on it in the thickness of 3 μm by the MOCVD method.

They were the same conditions as Example 1 and Example 2 like a description in Example 19 as conditions of MOCVD.

The above experimental result was collectively shown in Table 44.

Consequently, it is not based on the substrate which consists of a sintered compact which comprises an aluminum nitride as the main ingredients, and the substrate which consists of a sintered compact which comprises as the main ingredients a silicon carbide, a silicon nitride, a zinc oxide, a beryllium oxide, and an aluminum oxide at the surface state, but the thin film of the same crystallized state as the thin film produced in Example 25, such that the AlN thin film formed by the same sputtering method as the example 706 of an experiment was amorphous, the AlN thin film formed by the same sputtering method as the example 707 of an experiment was a polycrystal, and the AlN thin film formed by the same sputtering method as the example 708 of an experiment was an orientated polycrystal, was formed beforehand directly on the substrate which consists of each above-mentioned sintered compact.

On the other hand, when the sintered compact which comprises an aluminum nitride as the main ingredients was used as a substrate, formation of a 100 mol % AlN single crystal thin film was tried by the same MOCVD method as the example 709 of an experiment, but the thin film formed on the substrate in which average surface roughness Ra was larger than 2000 nm was a polycrystalline substance whose diffraction peak is shown only from the lattice plane of a Miller Index (002), (101), (102), and direct formation of a single crystal thin film was difficult on this substrate.

On the other hand, a single crystal thin film could be formed directly on the substrate in which average surface roughness Ra is not more than 2000 nm.

The 100 mol % AlN thin film which has each crystallized state of an amorphous state, a polycrystal, and an orientated polycrystal is formed beforehand by using the substrate which consists of a sintered compact which comprises an aluminum nitride as the main ingredients and whose average surface roughness Ra is larger than 2000 nm, the 100 mol % AlN thin film and the 100 mol % GaN thin film which were formed furthermore on it are single-crystal-ized, all the half width of the rocking curve of the X ray diffraction line from the lattice plane of the Miller Index (002) of this single crystal thin film was not more than 300 seconds.

The 100 mol % AlN thin film which has each crystallized state of an amorphous state, a polycrystal, and an orientated polycrystal is formed beforehand by using the substrate which consists of a sintered compact which comprises an aluminum nitride as the main ingredients and whose average surface roughness Ra is not more than 2000 nm, the 100 mol % AlN thin film and the 100 mol % GaN thin film which were formed furthermore on it are also single-crystal-ized, the half width of the rocking curve of the X ray diffraction line from the lattice plane of the Miller Index (002) of this single crystal thin film was not more than 100 seconds.

Moreover, when the sintered compact which comprises as the main ingredients a silicon carbide, a silicon nitride, a zinc oxide, a beryllium oxide, and an aluminum oxide is used as a substrate, formation of a 100 mol % AlN single crystal thin film was tried by the same MOCVD method as the example 709 of an experiment, but the thin film formed on the substrate in which average surface roughness Ra was larger than 1000 nm was a polycrystalline substance whose diffraction peak is shown only from the lattice plane of a Miller Index (002), (101), (102), and direct formation of a single crystal thin film was difficult on this substrate.

On the other hand, a single crystal thin film could be formed directly on the substrate in which average surface roughness Ra is not more than 1000 nm.

The 100 mol % AlN thin film which has each crystallized state of an amorphous state, a polycrystal, and an orientated polycrystal is formed beforehand by using the substrate which consists of a sintered compact which comprises as the main ingredients a silicon carbide, a silicon nitride, a zinc oxide, a beryllium oxide, and an aluminum oxide and whose average surface roughness Ra is larger than 1000 nm, the 100 mol % AlN thin film and the 100 mol % GaN thin film which were formed furthermore on it are single-crystal-ized, all the half width of the rocking curve of the X ray diffraction line from the lattice plane of the Miller Index (002) of this single crystal thin film was not more than 300 seconds.

The 100 mol % AlN thin film which has each crystallized state of an amorphous state, a polycrystal, and an orientated polycrystal is formed beforehand by using the substrate which consists of a sintered compact which comprises as the main ingredients a silicon carbide, a silicon nitride, a zinc oxide, a beryllium oxide, and an aluminum oxide and whose average surface roughness Ra is not more than 1000 nm, the 100 mol % AlN thin film and the 100 mol % GaN thin film which were formed furthermore on it are also single-crystal-ized, the half width of the rocking curve of the X ray diffraction line from the lattice plane of the Miller Index (002) of this single crystal thin film was not more than 200 seconds. The GaN thin film is also.

The 100 mol % AlN thin film which has the crystallized state of an orientated polycrystal is formed beforehand by using the substrate which consists of a sintered compact which comprises as the main ingredients a silicon carbide, a silicon nitride, a zinc oxide, a beryllium oxide, and an aluminum oxide and whose average surface roughness Ra is not more than 1000 nm, the 100 mol % AlN thin film and the 100 mol % GaN thin film which were formed furthermore on it are also single-crystal-ized, the half width of the rocking curve of the X ray diffraction line from the lattice plane of the Miller Index (002) of this single crystal thin film was not more than 150 seconds.

### EXAMPLE 30

This Example shows the example which investigated the composition of this substrate and the influence which gives to the crystallinity of the thin film which is formed on this substrate and comprises as the main ingredients a gallium nitride, an indium nitride, and an aluminum nitride, when the sintered compact which comprises a zinc oxide as the main ingredients is used as a substrate.

First, the guaranteed reagent powder by Kanto Kagaku incorporated company was prepared as zinc oxide (ZnO) powder, the Alcoa brand name “A-16SG” was prepared as a raw material as alumina (Al₂O₃) powder, it mixed by a ball mill so that it may become predetermined composition about such powders by the same method as Example 1, then paraffine wax was added and the powder for molding was produced, it degreased after a uniaxial press molding to the powder compact of the same size as Example 1, it carried out the normal pressure sintering at 1460 degrees C. for 1 hour in air after that, the sintered compact which comprises a zinc oxide as the main ingredients, and contains an aluminum ingredient at a various rate was produced.

Each of these sintered compacts was made dense to not less than 98% of relative density.

As for the sintered compact which was produced like this and comprises a zinc oxide as the main ingredients, though what does not contain an aluminum ingredient was light white yellow, what colored into blue was seen in what contains an aluminum ingredient, coloring progresses to deeper blue according as the content of an aluminum ingredient increases, the deepest blue is presented in the thing which includes Al₂O₃ 3.0 mol %, the grade of blue color became weak and changed to the color tone of blue white gradually according as the content of an aluminum ingredient increases after that.

In addition, Fe₂O₃ powder of purity not less than 99. 99% and Cr₂O₃ powder of purity not less than 99.9%, which were produced by Kojundo Chemical Laboratory Co., Ltd., were prepared in the other.

Y₂O₃ powder of purity not less than 99.99%, Er₂O₃ powder of purity not less than 99.99%, Yb₂O₃ powder of purity not less than 99.99%, Dy₂O₃ powder of purity not less than 99.99%, and Ho₂O₃ powder of purity not less than 99.99%, which were produced by Shin-Etsu Chemical Co., Ltd., were prepared as a rare earth element compound.

Next, by the same method as shown in this Example, each above-mentioned powder is mixed with zinc oxide powder and alumina powder by a predetermined quantity by using a ball mill, and was performed uniaxial press molding, then normal pressure sintering was carried out at 1460 degrees C. for 1 hour in air, so the sintered compact which comprises a zinc oxide as the main ingredients and contains only an iron ingredient, the sintered compact which comprises a zinc oxide as the main ingredients and contains only a chromium ingredient, the sintered compact which comprises a zinc oxide as the main ingredients and contains only a yttrium ingredient, the sintered compact which comprises a zinc oxide as the main ingredients and contains only an erbium ingredient, the sintered compact which comprises a zinc oxide as the main ingredients and contains only a ytterbium ingredient, the sintered compact which comprises a zinc oxide as the main ingredients and contains an aluminum ingredient and an iron ingredient simultaneously, the sintered compact which comprises a zinc oxide as the main ingredients and contains an aluminum ingredient and a chromium ingredient simultaneously, and the sintered compact which comprises a zinc oxide as the main ingredients and contains simultaneously an aluminum ingredient and various rare earth element ingredients were produced.

The electric resistivity in room temperature of each sintered compact obtained as mentioned above was measured by 4 terminal method.

After that, each sintered compact obtained was polished into specular surface by the abradant which comprises as the main ingredients colloidal silicon oxide of particle diameter of 0.02 μm, and was performed ultrasonic washing by methylene chloride and IPA, and the substrate was produced.

Average surface roughness Ra of the substrate after specular surface polish was in the range of 6.9 nm -7.7 nm.

The optical transmissivity to the light of 605 nm wavelength was measured by the same method as Example 2 using the substrate after polish.

Thus, the characteristic of the obtained substrate which consists of a sintered compact which comprises a zinc oxide as the main ingredients is shown in Table 45 and 46.

Among the produced above-mentioned substrates which consist of a sintered compact which comprises a zinc oxide as the main ingredients, the characteristic of what contains only an aluminum ingredient, and what contains only a chromium ingredient, an iron ingredient, a yttrium ingredient, an erbium ingredient, and a ytterbium ingredient excluding an aluminum ingredient was indicated in Table 45.

On the other hand, the characteristic of the substrate which consists of a sintered compact which comprises a zinc oxide as the main ingredients and contains simultaneously an aluminum ingredient, a chromium ingredient, an iron ingredient, and various rare earth element ingredients was indicated in Table 46.

In Table 45, experiment No. 1150-1193 is an experimental result about the sintered compact which comprises a zinc oxide as the main ingredients and which added only the aluminum ingredient and was fired, the content of the aluminum ingredient of this sintered compact is shown in the column of “composition” by Al₂O₃ conversion.

In Table 45, experiment No. 1194-1195 is an experimental result about the sintered compact which comprises a zinc oxide as the main ingredients and which added only the iron ingredient and was fired, the content of the iron ingredient of this sintered compact is shown in the column of “composition” by Fe₂O₃ conversion.

In Table 45, experiment No. 1196-1197 is an experimental result about the sintered compact which comprises a zinc oxide as the main ingredients and which added only the chromium ingredient and was fired, the content of the chromium ingredient of this sintered compact is shown in the column of “composition” by Cr₂O₃ conversion.

In Table 45, experiment No. 1198-1199 is an experimental result about the sintered compact which comprises a zinc oxide as the main ingredients and which added only the yttrium ingredient and was fired, the content of the yttrium ingredient of this sintered compact is shown in the column of “composition” by Y₂O₃ conversion.

In Table 45, experiment No. 1198-1199 is an experimental result about the sintered compact which comprises a zinc oxide as the main ingredients and which added only the erbium ingredient and was fired, the content of the erbium ingredient of this sintered compact is shown in the column of “composition” by Er₂O₃ conversion.

In Table 45, experiment No. 1198-1199 is an experimental result about the sintered compact which comprises a zinc oxide as the main ingredients and which added only the ytterbium ingredient and was fired, the content of the ytterbium ingredient of this sintered compact is shown in the column of “composition” by Yb₂O₃ conversion.

As shown in Table 45, as for the sintered compact which comprises a zinc oxide as the main ingredients and was produced in this Example, what does not contain an aluminum ingredient is an electric insulator, electric resistivity lowers according as the content of an aluminum ingredient increases, the electric resistivity in room temperature became the smallest with 1.6×10⁻³ Ω·cm in what includes an aluminum ingredient 3.0 mol % by Al₂O₃ conversion.

After that, electric resistivity began to increase according as the content of an aluminum ingredient increases, it became an electric insulator in the thing which includes aluminum ingredient 50.0 mol % by Al₂O₃ conversion.

As shown in experiment No. 1194-1197 of Table 45, the sintered compact which comprises a zinc oxide as the main ingredients and which does not contain an aluminum ingredient and contains an iron ingredient 1.0 mol % by Fe₂O₃ conversion, and a chromium ingredient 1.0 mol % by Cr₂O₃ conversion respectively, shows conductivity, it was 8.7×10⁻¹ Ω·cm, 3.4×10⁻¹ Ω·cm in room temperature and was comparatively low electric resistivity.

As shown in Table 46, all the sintered compacts which comprise a zinc oxide as the main ingredients and which contain an iron ingredient, a chromium ingredient, and various rare earth element ingredients simultaneously with an aluminum ingredient show conductivity, it was in the range of 7.4×10¹ Ω·cm-1.7×10⁻³ Ω·cm as electric resistivity in room temperature.

To electric resistivity of what contains only an aluminum ingredient as the sintered compact which comprises a zinc oxide as the main ingredients, the electric resistivity seldom changed and was the almost same level.

As shown in Table 45, as for the optical transmissivity of the sintered compact which comprises a zinc oxide as the main ingredients and which is fired without adding an aluminum ingredient and is not included except the impurities substantially mixed in a raw material or at the time of sintered compact manufacture, it was 16% to the light of 605 nm wavelength, but optical transmissivity shows the tendency to go up as the content of an aluminum ingredient increases, what contains a 3.0-mol % aluminum ingredient by Al₂O₃ conversion was reached to 56%.

After that, optical transmissivity shows the tendency to lower gradually according as the content of an aluminum ingredient increases, in the sintered compact which comprises a zinc oxide as the main ingredients and contains a 50.0-mol % aluminum ingredient by Al₂O₃ conversion, optical transmissivity became 17%, it became almost the same as the optical transmissivity of the sintered compact which does not contain an aluminum ingredient and which consists only of a zinc oxide substantially.

As shown in experiment No. 1194-1197 of Table 45, in the light of 605 nm wavelength, the optical transmissivity of the sintered compact which comprises a zinc oxide as the main ingredients and which contains an iron ingredient 1.0 mol % by Fe₂O₃ conversion, and a chromium ingredient 1.0 mol % by Cr₂O₃ conversion, respectively, excluding an aluminum ingredient was 6.9% and 9.2%, respectively.

As shown in experiment No. 1198-1203 of Table 45, the optical transmissivity of the sintered compact which comprises a zinc oxide as the main ingredients and which does not contain an aluminum ingredient and contains only a yttrium ingredient 0.04 mol % by Y₂O₃ conversion, only an erbium ingredient 0.04 mol % by Er₂O₃ conversion, and only a ytterbium ingredient 0.04 mol % by Yb₂O₃ conversion, respectively, became 57%, 53%, and 54% to the light of 605 nm wavelength, it went up rather than the optical transmissivity of the sintered compact which does not contain an aluminum ingredient and which consists only of a zinc oxide substantially.

Furthermore, as shown in Table 46, the optical transmissivity of the sintered compact which comprises a zinc oxide as the main ingredients and which contains an aluminum ingredient 3.0 mol % by Al₂O₃ conversion and contains simultaneously an iron ingredient or a chromium ingredient 0.2 mol % by Fe₂O₃ conversion, 0.2 mol % by Cr₂O₃ conversion, respectively, is 53% and 55% to the light of 605 nm wavelength, it was almost the same as the optical transmissivity of the sintered compact which comprises a zinc oxide as the main ingredients and contains only an aluminum ingredient 3.0 mol % by Al₂O₃ conversion.

As shown in Table 46, as for the sintered compact which comprises a zinc oxide as the main ingredients and which contains an aluminum ingredient 0.03 mol % by Al₂O₃ conversion and contains simultaneously a yttrium ingredient in the range of 0.0001 mol %-12.0 mol % by Y₂O₃ conversion, the optical transmissivity of what contains a yttrium ingredient 0.0001 mol % by Y₂O₃ conversion was 28% to the light of 605 nm wavelength, it was almost the same as the optical transmissivity of the sintered compact which comprises a zinc oxide as the main ingredients and contains only an aluminum ingredient 0.03 mol % by Al₂O₃ conversion.

Furthermore, optical transmissivity also rises according as the content of a yttrium ingredient increases, it reached to 37% in what contains a yttrium ingredient 0.0004 mol % by Y₂O₃ conversion, 45% in what contains a yttrium ingredient 0.0008 mol % by Y₂O₃ conversion, 56% in what contains a yttrium ingredient 0.0015 mol % by Y₂O₃ conversion, 64% in what contains a yttrium ingredient 0.005 mol % by Y₂O₃ conversion, 68% in what contains a yttrium ingredient 0.04 mol % by Y₂O₃ conversion.

After that, optical transmissivity lowers gradually according as the content of a yttrium ingredient increases, the optical transmissivity to the light of 605 nm wavelength became 24% in the sintered compact which comprises a zinc oxide as the main ingredients and contains a yttrium ingredient 12.0 mol % by Y₂O₃ conversion, it became almost the same as the optical transmissivity of the sintered compact which comprises a zinc oxide as the main ingredients and contains only an aluminum ingredient 0.03 mol % by Al₂O₃ conversion.

As shown in Table 46, as for the sintered compact which comprises a zinc oxide as the main ingredients and which contains. a yttrium ingredient 0.04 mol % by Y₂O₃ conversion and contains simultaneously an aluminum ingredient in the range of 0.002 mol %-50.0 mol % by Al₂O₃ conversion, the optical transmissivity of what contains an aluminum ingredient 0.002 mol % by Al₂O₃ conversion was 62% to the light of 605 nm wavelength.

Furthermore, optical transmissivity also rises according as the content of an aluminum ingredient increases, it reached to 84% in what contains an aluminum ingredient 1.0 mol % and 3.0 mol % by Al₂O₃ conversion.

After that, optical transmissivity lowers gradually according as the content of an aluminum ingredient increases, although optical transmissivity was 66% in what contains a 30.0 mol % aluminum ingredient by Al₂O₃ conversion, the optical transmissivity to the light of 605 nm wavelength became 27% in the sintered compact which comprises a zinc oxide as the main ingredients and contains a 50.0 mol % aluminum ingredient by Al₂O₃ conversion.

As shown in Table 46, the optical transmissivity to the light of 605 nm wavelength was 68% in the sintered compact which comprises a zinc oxide as the main ingredients and contains an aluminum ingredient 0.10 mol % by Al₂O₃ conversion and simultaneously an erbium ingredient 0.04 mol % by Er₂O₃ conversion.

As shown in Table 46, the optical transmissivity of what contains an aluminum ingredient 3.0 mol % by Al₂O₃ conversion and contains simultaneously a dysprosium ingredient 0.04 mol % by Dy₂O₃ conversion, a holmium ingredient 0.04 mol % by Ho₂O₃ conversion, an erbium ingredient 0.04 mol % by Er₂O₃ conversion, and a ytterbium ingredient 0.04 mol % by Yb₂O₃ conversion as a rare earth element ingredient was as high as 77%, 80%, 78%, and 81%, respectively, to the light of 605 nm wavelength.

As shown in Table 46, the optical transmissivity of the sintered compact which comprises a zinc oxide as the main ingredients and contains simultaneously three ingredients which include an aluminum ingredient 1.0 mol % by Al₂O₃ conversion, further include a yttrium ingredient 0.02 mol % by Y₂O₃ conversion, and further include an erbium ingredient 0.02 mol % by Er₂O₃ conversion was as high as 83% to the light of 605 nm wavelength.

Next, the thin film was formed by the same method as what was shown in Example 27 to the prepared above-mentioned substrate.

That is, choosing a part of prepared substrate, the thin film of 100 mol % AlN was formed beforehand on it in the thickness of 3 μm by the same conditions as the sputtering method performed in experiment No. 706, 707, and 708, and the MOCVD method performed in experiment No. 709 of Example 25.

Furthermore, the thin film of 100 mol % GaN was formed beforehand in the thickness of 3 Jim by the same conditions as the MOCVD method performed in experiment No. 728 and 730, and the thin film of 100 mol % InN was formed beforehand in the thickness of 3 μm by the same condition as the MOCVD method performed in experiment No. 731.

As for the thin film formed beforehand on the substrate which consists of a sintered compact which comprises a zinc oxide as the main ingredients and contains simultaneously an aluminum ingredient and an iron ingredient, a sintered compact which comprises a zinc oxide as the main ingredients and contains simultaneously an aluminum ingredient and a chromium ingredient, and a sintered compact which comprises a zinc oxide as the main ingredients and contains simultaneously an aluminum ingredient and various rare earth element ingredients, it used only a 100 mol % AlN by the sputtering method performed in experiment No. 708 of Example 25.

Next, using the above mentioned substrate which consists of a sintered compact which comprises a zinc oxide as the main ingredients and formed beforehand the thin film which comprises an aluminum nitride as the main ingredients, the thin film which comprises a gallium nitride as the main ingredients, and the thin film which comprises an indium nitride as the main ingredients, and the substrate which consists of a sintered compact which comprises a zinc oxide as the main ingredients and which was left without forming a thin film, the thin films of each composition of the same 100 mol % AlN, 100 mol % GaN, 100 mol % InN, 50 mol % AlN+50 mol % GaN, and 50 mol % GaN+50 mol % InN as what was described in Example 19 were formed furthermore on it in the thickness of 3 μm by the MOCVD method.

They were the same conditions as Example 1 and Example 2 like a description in Example 19 as conditions of MOCVD.

Thus, the characteristic of the thin film produced like that was shown in Table 45 and Table 46.

In this Example, as each thin film formed beforehand on each above-mentioned substrate the thing of the crystallized state corresponding to each formation condition was formed.

That is, the AlN thin film formed by the sputtering method of the same condition as experiment No. 706 was amorphous, and the AlN thin film formed by the sputtering method of the same condition as experiment No. 707 was the polycrystal whose diffraction lines have appeared only from the lattice plane of a Miller Index (002), (101), (102).

As for the AlN thin film formed by the sputtering method of the same conditions as experiment No. 708, only the diffraction line from the lattice plane of a Miller Index (002) has appeared, it was the orientated polycrystal formed in the direction where C axis is perpendicular to the substrate surface.

As for the AlN thin film formed by the MOCVD method of the same conditions as experiment No. 709, only the diffraction line from the lattice plane of a Miller Index (002) has appeared, it was confirmed that it is the single crystal formed in the direction where C axis is perpendicular to the substrate surface.

The GaN thin film formed by the MOCVD method of the same condition as experiment No. 728 was amorphous, as for the GaN thin film formed by the MOCVD method of the same condition as experiment No. 730, only the diffraction line from the lattice plane of a Miller Index (002) has appeared, it was the orientated polycrystal formed in the direction where C axis is perpendicular to the substrate surface.

As for the InN thin film formed by the MOCVD method of the same conditions as experiment No. 731, only the diffraction line from the lattice plane of a Miller Index (002) has appeared, it was the orientated polycrystal formed in the direction where C axis is perpendicular to the substrate surface.

If the crystallinity of the 100 mol % AlN orientated polycrystalline thin film formed by the same sputtering method as experiment No. 708 is seen, as shown in Table 45, when the substrate which consists of a sintered compact which comprises a zinc oxide as the main ingredients and does not contain an aluminum ingredient substantially was used, the half width of the rocking curve of the X ray diffraction line from the lattice plane of the Miller Index (002) of this orientated polycrystalline thin film was 9430 seconds.

The crystallinity of this orientated polycrystalline thin film showed the tendency to improve according as the aluminum ingredient increases.

That is, when using the substrate which consists of a sintered compact which comprises a zinc oxide as the main ingredients and contains an aluminum ingredient 0.002 mol % by Al₂O₃ conversion, the half width of the rocking curve of the X ray diffraction line from the lattice plane of the Miller Index (002) of the AlN orientated polycrystalline thin film formed on this substrate is 8190 seconds, it was 7620 seconds when using the substrate which consists of a sintered compact which comprises a zinc oxide as the main ingredients and contains an aluminum ingredient 0.008 mol % by Al₂O₃ conversion, it fell to not more than 8000 seconds.

After that, the crystallinity of this AlN orientated polycrystalline thin film showed the tendency which improves a little according as the content of an aluminum ingredient increases, when the substrate which comprises a zinc oxide as the main ingredients and contains 3.0 mol % by Al₂O₃ conversion is used, what is 7320 seconds-7460 seconds was formed, and crystallinity improved most.

After that, crystallinity showed the tendency which a little lowers according as the content of an aluminum ingredient increases.

When using the substrate which comprises a zinc oxide as the main ingredients and whose content of an aluminum ingredient is 40.0 mol % by Al₂O₃ conversion, the crystallinity of this AlN orientated polycrystalline thin film was 7530 seconds-7570 seconds.

However, in the case of 100 mol % AlN orientated polycrystalline thin film formed on the substrate which consists of a sintered compact which comprises a zinc oxide as the main ingredients and contains an aluminum ingredient 50.0 mol % by Al₂O₃ conversion, it was 9260 seconds and crystallinity fell.

As shown in Table 46, when having used the substrate which comprises a zinc oxide as the main ingredients and which contains an aluminum ingredient 45.0 mol % by Al₂O₃ conversion and further contains an iron ingredient, a chromium ingredient, and at least one or more ingredients selected from rare earth element ingredients, the half width of the rocking curve of the X ray diffraction line from the lattice plane of the Miller Index (002) of the AlN orientated polycrystalline thin film formed on this substrate is in the range of 7380 seconds-7920 seconds, it was not more than 8000 seconds altogether.

Next, as for the thin film which consists of each composition of 100 mol % AlN, 100 mol % GaN, and 100 mol % InN and which was formed by the above-mentioned MOCVD method using the substrate which consists of a sintered compact which comprises a zinc oxide as the main ingredients and was left without forming the above-mentioned thin film, the crystallinity was investigated by X ray diffraction.

Consequently, it was confirmed that all the produced thin films are the single crystals formed in the direction where C axis is perpendicular to the substrate surface.

If the crystallinity is seen, as shown in Table 45, when having used the sintered compact which comprises a zinc oxide as the main ingredients and which is fired without adding an aluminum ingredient and is not included except the impurities substantially mixed in a raw material or at the time of sintered compact manufacture, the half width of the rocking curve of the X ray diffraction line from the lattice plane of the Miller Index (002) of the 100 mol % AlN single crystal thin film directly formed on this substrate was 255 seconds.

On the other hand, in the case of the 100 mol % AlN single crystal thin film which was formed directly on the substrate which consists of a sintered compact which comprises a zinc oxide as the main ingredients and contains an aluminum ingredient 0.002 mol % by Al₂O₃ conversion, it became small at 187 seconds, and its crystallinity improved.

In the case of the 100 mol % AlN single crystal thin film which was formed directly on the substrate which consists of a sintered compact which comprises a zinc oxide as the main ingredients and contains an aluminum ingredient 0.008 mol % by Al₂O₃ conversion, it is 159 seconds, and its crystallinity improved more.

In the case of the 100 mol % AlN single crystal thin film which was formed directly on the substrate which consists of a sintered compact which comprises a zinc oxide as the main ingredients and contains an aluminum ingredient 0.03 mol % by Al₂O₃ conversion, it is 138 seconds, and its crystallinity improved further.

In the case of the 100 mol % AlN single crystal thin film which was formed directly on the substrate which consists of a sintered compact which comprises a zinc oxide as the main ingredients and contains an aluminum ingredient 0.1 mol % by Al₂O₃ conversion, it was 126 seconds, it became not more than 130 seconds and its crystallinity improved further.

Furthermore, the half width of the rocking curve of the X ray diffraction line from the lattice plane of the Miller Index (002) of the single crystal thin film directly formed on the substrate which consists of a sintered compact which comprises a zinc oxide as the main ingredients became small as the content of an aluminum ingredient increased.

In the case of the 100 mol % AlN single crystal thin film which was formed directly on the substrate which consists of a sintered compact which comprises a zinc oxide as the main ingredients and contains an aluminum ingredient 3.0 mol % by Al₂O₃ conversion, it became the smallest in this Example at 112 seconds, and crystallinity was most excellent.

After that, the half width of the rocking curve of the X ray diffraction line from the lattice plane of the Miller Index (002) of the single crystal thin film directly formed on the substrate which consists of a sintered compact which comprises a zinc oxide as the main ingredients becomes large as the content of an aluminum ingredient increases, in the case of the 100 mol % AlN single crystal thin film which was formed directly on the substrate which consists of a sintered compact which comprises a zinc oxide as the main ingredients and contains an aluminum ingredient 40.0 mol % by Al₂O₃ conversion, it had been 136 seconds.

In the case of the 100 mol % AlN single crystal thin film which was formed directly on the substrate which consists of a sintered compact which comprises a zinc oxide as the main ingredients and contains an aluminum ingredient 50.0 mol % by Al₂O₃ conversion, it had been 229 seconds, and it became larger than 200 seconds.

On the other hand, as shown in Table 45 and 46 in this Example, as for the substrate which consists of a sintered compact which comprises a zinc oxide as the main ingredients and includes an aluminum ingredient, even if ingredients other than aluminum, such as iron, chromium, or a rare earth element etc., were contained in this sintered compact, it was confirmed that there is little change of lowering greatly the crystallinity of a single crystal thin film which is directly formed on this substrate and comprises as the main ingredients at least one or more materials selected from a gallium nitride, an indium nitride, and an aluminum nitride.

If saying in other words, as for the substrate which consists of a sintered compact which comprises a zinc oxide as the main ingredients and includes an aluminum ingredient, even if ingredients other than aluminum, for example, iron, chromium, or a rare earth element etc., were contained in this sintered compact, it was confirmed that the crystallinity of the single crystal thin film directly formed on this substrate is what cannot be influenced easily by these ingredients.

Concretely, the half width of the rocking curve of the X ray diffraction line from the lattice plane of the Miller Index (002) of the 100 mol % AlN single crystal thin film directly formed on the substrate which consists of a sintered compact which comprises a zinc oxide as the main ingredients and which contains an aluminum ingredient 0.03 mol % by Al₂O₃ conversion and contains a yttrium ingredient simultaneously in the range of 0.0001 mol %-12.0 mol % by Y₂O₃ conversion is in the range of 134 seconds-145 seconds, as for the crystallinity, the tendency to change a lot from 138 seconds of the 100 mol % AlN single crystal thin film directly formed on the substrate which consists of a sintered compact which comprises a zinc oxide as the main ingredients and which contains only an aluminum ingredient 0.03 mol % by Al₂O₃ conversion and does not contain yttrium ingredient was not shown.

Furthermore, in Table 45 and Table 46, the half width of the rocking curve of the X ray diffraction line from the lattice plane of the Miller Index (002) of the 100 mol % AlN single crystal thin film directly formed on the substrate which consists of a sintered compact which comprises a zinc oxide as the main ingredients and which contains an aluminum ingredient 3.0 mol % by Al₂O₃ conversion and contains simultaneously an iron ingredient 0.2 mol % by Fe₂O₃ conversion, a chromium ingredient 0.2 mol % by Cr₂O₃ conversion, a yttrium ingredient 0.04 mol % by Y₂O₃ conversion, a holmium ingredient 0.04 mol % by Ho₂O₃ conversion, and an erbium ingredient 0.04 mol % by Er₂O₃ conversion respectively is in the range of 111 seconds-117 seconds, as for the crystallinity, the tendency to change a lot from 112 seconds of the 100 mol % AlN single crystal thin film directly formed on the substrate which consists of a sintered compact which comprises a zinc oxide as the main ingredients and contains only an aluminum ingredient 3.0 mol % by Al₂O₃ conversion was not shown.

The half width of the rocking curve of the X ray diffraction line from the lattice plane of the Miller Index (002) of the 100 mol % GaN single crystal thin film directly formed on the substrate which consists of a sintered compact which comprises a zinc oxide as the main ingredients and which contains an aluminum ingredient 3.0 mol % by Al₂O₃ conversion and contains simultaneously a dysprosium ingredient 0.04 mol % by Dy₂O₃ conversion, and a ytterbium ingredient 0.04 mol % by Yb₂O₃ conversion, respectively, is in the range of 116 seconds-113 seconds, as for the crystallinity, the tendency to change a lot from 118 seconds of the 100 mol % GaN single crystal thin film directly formed on the substrate which consists of a sintered compact which comprises a zinc oxide as the main ingredients and contains only an aluminum ingredient 3.0 mol % by Al₂O₃ conversion was not shown.

In Table 45 and Table 46, if the crystallinity of the 100 mol % AlN single crystal thin film directly formed on the substrate which consists of a sintered compact which comprises a zinc oxide as the main ingredients and which contains a yttrium ingredient 0.04 mol % by Y₂O₃ conversion and contains simultaneously an aluminum ingredient in the range of 0.002 mol %-50.0 mol % by Al₂O₃ conversion is compared with the crystallinity of the 100 mol % AlN single crystal thin film directly formed on the substrate which consists of a sintered compact which comprises a zinc oxide as the main ingredients and which only contains an aluminum ingredient, it seldom changed about this crystallinity, but was the almost same level in the substrate which consists of a sintered compact which comprises a zinc oxide as the main ingredients and contains the same quantity of an aluminum ingredient, respectively.

For example, the half width of the rocking curve of the X ray diffraction line from the lattice plane of the Miller Index (002) of the 100 mol % AlN single crystal thin film directly formed on the substrate which consists of a sintered compact which comprises a zinc oxide as the main ingredients and which contains a yttrium ingredient 0.04 mol % by Y₂O₃ conversion and contains simultaneously an aluminum ingredient 0.002 mol % by Al₂O₃ conversion is 175 seconds, as for the crystallinity, the change tendency of lowering greatly from 187 seconds of the 100 mol % AlN single crystal thin film directly formed on the substrate which consists of a sintered compact which comprises a zinc oxide as the main ingredients and which contains only an aluminum ingredient 0.002 mol % by Al₂O₃ conversion and does not contain a yttrium ingredient substantially was not shown.

The half width of the rocking curve of the X ray diffraction line from the lattice plane of the Miller Index (002) of the 100 mol % AlN single crystal thin film directly formed on the substrate which consists of a sintered compact which comprises a zinc oxide as the main ingredients and which contains a yttrium ingredient 0.04 mol % by Y₂O₃ conversion and contains simultaneously an aluminum ingredient 0.10 mol % by Al₂O₃ conversion is 125 seconds, as for the crystallinity, the change tendency of lowering greatly from 126 seconds of the 100 mol % AlN single crystal thin film directly formed on the substrate which consists of a sintered compact which comprises a zinc oxide as the main ingredients and which contains only an aluminum ingredient 0.10 mol % by Al₂O₃ conversion and does not contain a yttrium ingredient substantially was not shown.

The half width of the rocking curve of the X ray diffraction line from the lattice plane of the Miller Index (002) of the 100 mol % AlN single crystal thin film directly formed on the substrate which consists of a sintered compact which comprises a zinc oxide as the main ingredients and which contains a yttrium ingredient 0.04 mol % by Y₂O₃ conversion and contains simultaneously an aluminum ingredient 30.0 mol % by Al₂O₃ conversion is 126 seconds, as for the crystallinity, the change tendency of lowering greatly from 127 seconds of the 100 mol % AlN single crystal thin film directly formed on the substrate which consists of a sintered compact which comprises a zinc oxide as the main ingredients and which contains only an aluminum ingredient 30.0 mol % by Al₂O₃ conversion and does not contain a yttrium ingredient substantially was not shown.

That is, as for the crystallinity of the 100 mol % AlN single crystal thin film directly formed on the sintered compact which comprises a zinc oxide as the main ingredients and contains an aluminum ingredient in the range of 0.002 mol %-50.0 mol % by Al₂O₃ conversion, even if the yttrium ingredient was simultaneously contained in this sintered compact which comprises a zinc oxide as the main ingredients in addition to the aluminum ingredient, it hardly changed but having the tendency to be hard to be influenced by the existence of a yttrium ingredient was confirmed.

Furthermore, the half width of the rocking curve of the X ray diffraction line from the lattice plane of the Miller Index (002) of the 100 mol % GaN single crystal thin film directly formed on the substrate which consists of a sintered compact which comprises a zinc oxide as the main ingredients and which contains a yttrium ingredient 0.04 mol % by Y₂O₃ conversion and contains simultaneously an aluminum ingredient 1.0 mol % by Al₂O₃ conversion is 119 seconds, as for the crystallinity, the change tendency of lowering greatly from 121 seconds of the 100 mol % AlN single crystal thin film directly formed on the substrate which consists of a sintered compact which comprises a zinc oxide as the main ingredients and contains only an aluminum ingredient 1.0 mol % by Al₂O₃ conversion was not shown.

In Table 45 and Table 46, the half width of the rocking curve of the X ray diffraction line from the lattice plane of the Miller Index (002) of the 100 mol % GaN single crystal thin film directly formed on the sintered compact which comprises a zinc oxide as the main ingredients and contains simultaneously three ingredients of an aluminum ingredient of 1.0 mol % by Al₂O₃ conversion, further a yttrium ingredient of 0.04 mol % by Y₂O₃ conversion, and an erbium ingredient of 0.04 mol % by Er₂O₃ conversion is 116 seconds, as for the crystallinity, the tendency to change a lot from 118 seconds of the 100 mol % GaN single crystal thin film directly formed on the substrate which consists of a sintered compact which comprises a zinc oxide as the main ingredients and contains only an aluminum ingredient 3.0 mol % by Al₂O₃ conversion was not shown.

In addition to this, as shown in Table 45, when the sintered compact which comprises a zinc oxide as the main ingredients and contains an iron ingredient 1.0 mol % by Fe₂O₃ conversion excluding an aluminum ingredient was used for a substrate, the half width of the rocking curve of the X ray diffraction line from the lattice plane of the Miller Index (002) of the single crystal thin film directly formed on this substrate was 227 seconds.

When the sintered compact which comprises a zinc oxide as the main ingredients and contains a chromium ingredient 1.0 mol % by Cr₂O₃ conversion excluding an aluminum ingredient was used for a substrate, the half width of the rocking curve of the X ray diffraction line from the lattice plane of the Miller Index (002) of the single crystal thin film directly formed on this substrate was 220 seconds.

When the sintered compact which comprises a zinc oxide as the main ingredients and contains a yttrium ingredient 0.04 mol % by Y₂O₃ conversion excluding an aluminum ingredient was used for a substrate, the half width of the rocking curve of the X ray diffraction line from the lattice plane of the Miller Index (002) of the single crystal thin film directly formed on this substrate was 192 seconds, it was not more than 200 seconds.

When the sintered compact which comprises a zinc oxide as the main ingredients and contains an erbium ingredient 0.04 mol % by Er₂O₃ conversion excluding an aluminum ingredient was used for a substrate, the half width of the rocking curve of the X ray diffraction line from the lattice plane of the Miller Index (002) of the single crystal thin film directly formed on this substrate was 206 seconds.

When the sintered compact which comprises a zinc oxide as the main ingredients and contains a ytterbium ingredient 0.04 mol % by Yb₂O₃ conversion excluding an aluminum ingredient was used for a substrate, the half width of the rocking curve of the X ray diffraction line from the lattice plane of the Miller Index (002) of the single crystal thin film directly formed on this substrate was 203 seconds.

Thus, in this Example, even if it is the sintered compact which comprises a zinc oxide as the main ingredients and contains ingredients, such as iron, chromium, yttrium, erbium, and ytterbium, excluding an aluminum ingredient substantially, when this sintered compact was used as a substrate, it was confirmed that the comparatively good crystalline single crystal thin film which comprises as the main ingredients at least one or more materials selected from a gallium nitride, an indium nitride, and an aluminum nitride is directly formed on this substrate.

Using as a substrate the sintered compact which consists only of a zinc oxide substantially and which is fired without adding an aluminum ingredient and other ingredients and does not include other than the impurities in a raw material, when the crystallinity was compared with 255 seconds of the 100 mol % AlN single crystal thin film which was directly formed on this substrate, it was not inferior.

As mentioned above, all the half width of the rocking curve of the X ray diffraction line from the lattice plane of the Miller Index (002) of the 100 mol % AlN single crystal thin film, the 100 mol % GaN single crystal thin film, and the 100 mol % InN single crystal thin film which were directly formed on the substrate which consists of a sintered compact of various compositions which comprises a zinc oxide as the main ingredients was not more than 300 seconds, it was excellent in crystallinity.

When the above-mentioned substrate which consists of a sintered compact of various compositions which comprises a zinc oxide as the main ingredients and has such characteristics is used, if the thin film which comprises as the main ingredients at least one or more materials selected from a gallium nitride, an indium nitride, and an aluminum nitride and has various crystallized state, such as an amorphous state, a polycrystal, an orientated polycrystal, and a single crystal etc., is formed beforehand on this substrate and the single crystal thin film which comprises as the main ingredients at least one or more materials selected from a gallium nitride, an indium nitride, and an aluminum nitride is formed furthermore on it, it was confirmed that the crystallinity of this single crystal thin film obtained was more excellent than the crystallinity of the single crystal thin film which is directly formed on this substrate and comprises as the main ingredients at least one or more materials selected from a gallium nitride, an indium nitride, and an aluminum nitride.

That is, when using the sintered compact which comprises a zinc oxide as the main ingredients and has various compositions is used as a substrate, as for the half width of the rocking curve of the X ray diffraction line from the lattice plane of the Miller Index (002) of the single crystal thin film which comprises as the main ingredients at least one or more materials selected from a gallium nitride, an indium nitride, and an aluminum nitride, it does not necessarily become into not more than 200 seconds.

On the other hand, even if the sintered compact which comprises a zinc oxide as the main ingredients and has such various compositions is used as a substrate, if the thin film which comprises as the main ingredients at least one or more materials selected from a gallium nitride, an indium nitride, and an aluminum nitride and has various crystallized state, such as an amorphous state, a polycrystal, an orientated polycrystal, and a single crystal etc., is formed beforehand on this substrate and the single crystal thin film which comprises as the main ingredients at least one or more materials selected from a gallium nitride, an indium nitride, and an aluminum nitride is formed furthermore on it, it was confirmed that the thing which is not more than 200 seconds can be formed as half width of the rocking curve of the X ray diffraction line from the lattice plane of the Miller Index (002) of this single crystal thin film.

When the single crystal thin film which comprises as the main ingredients at least one or more materials selected from a gallium nitride, an indium nitride, and an aluminum nitride is formed by using the substrate which consists of a sintered compact which comprises a zinc oxide as the main ingredients and is the same composition, if the thin film which comprises as the main ingredients at least one or more materials selected from a gallium nitride, an indium nitride, and an aluminum nitride and has various crystallized state, such as an amorphous state, a polycrystal, an orientated polycrystal, and a single crystal etc., is formed beforehand on this substrate and the single crystal thin film which comprises as the main ingredients at least one or more materials selected from a gallium nitride, an indium nitride, and an aluminum nitride is formed furthermore on it, it was confirmed that the crystallinity of this single crystal thin film obtained was more excellent than the crystallinity of the single crystal thin film which is directly formed on this substrate and comprises as the main ingredients at least one or more materials selected from a gallium nitride, an indium nitride, and an aluminum nitride.

That is, if the thin film which comprises as the main ingredients at least one or more materials selected from a gallium nitride, an indium nitride, and an aluminum nitride and has various crystallized state, such as an amorphous state, a polycrystal, an orientated polycrystal, and a single crystal etc., is formed beforehand on the substrate which consists of a sintered compact which comprises a zinc oxide as the main ingredients and contains an aluminum ingredient in the range of 0.001 mol %-45.0 mol % by Al₂O₃ conversion and the single crystal thin film which comprises as the main ingredients at least one or more materials selected from a gallium nitride, an indium nitride, and an aluminum nitride is formed furthermore on it, the half width of the rocking curve of the X ray diffraction line from the lattice plane of the Miller Index (002) of this single crystal thin film tends to become not more than 130 seconds, when the sintered compact which comprises a zinc oxide as the main ingredients and contains an aluminum ingredient in the range of 0.005 mol %-45.0 mol % by Al₂O₃ conversion is used as a substrate, it was confirmed that the thing which is not more than 100 seconds can be formed as half width of the rocking curve of the X ray diffraction line from the lattice plane of the Miller Index (002) of this single crystal thin film.

Furthermore, even if it is the substrate which consists of a sintered compact which comprises a zinc oxide as the main ingredients and which contains the above amount of an aluminum ingredient, and besides it, contains simultaneously ingredients, such as an iron ingredient, a chromium ingredient, a yttrium ingredient, a dysprosium ingredient, a holmium ingredient, an erbium ingredient, and a ytterbium ingredient, if the crystallinity of the single crystal thin film formed on this substrate is compared with the crystallinity of the single crystal thin film formed on the above-mentioned substrate which consists of a sintered compact which comprises a zinc oxide as the main ingredients and which does not contain substantially other ingredients, such as an iron ingredient, a chromium ingredient, a yttrium ingredient, a dysprosium ingredient, a holmium ingredient, an erbium ingredient, and a ytterbium ingredient, including an aluminum ingredient, it was confirmed that it is hard to receive change of it lowering greatly.

That is, if it is the substrate which consists of a sintered compact which comprises a zinc oxide as the main ingredients and contains the above amount of an aluminum ingredient, even if ingredients other than an aluminum ingredient, such as an iron ingredient, a chromium ingredient, a yttrium ingredient, a dysprosium ingredient, a holmium ingredient, an erbium ingredient, and a ytterbium ingredient, were contained, it was confirmed that the crystallinity of the single crystal thin film formed is what cannot be influenced easily by these ingredients.

More concretely, as shown in Table 45, while the half width of the rocking curve of the X ray diffraction line from the lattice plane of the Miller Index (002) of the 100 mol % AlN single crystal thin film directly formed on the substrate which consists of a sintered compact which comprises a zinc oxide as the main ingredients and which is fired without adding an aluminum ingredient and is not included except the impurities substantially mixed in a raw material or at the time of sintered compact manufacture is 255 seconds, the half width of the rocking curve of the X ray diffraction line from the lattice plane of the Miller Index (002) of the 100 mol % AlN single crystal thin film formed furthermore on it is 136 seconds when beforehand forming the orientated polycrystal of 100 mol % AlN on the substrate which consists of the same sintered compact which comprises a zinc oxide as the main ingredients, so the crystallinity improved.

On the other hand, while the half width of the rocking curve of the X ray diffraction line from the lattice plane of the Miller Index (002) of the 100 mol % AlN single crystal thin film directly formed on this substrate is 187 seconds when using the substrate which consists of a sintered compact which comprises a zinc oxide as the main ingredients and contains an aluminum ingredient 0.002 mol % by Al₂O₃ conversion, the half width of the rocking curve of the X ray diffraction line from the lattice plane of the Miller Index (002) of the 100 mol % AlN single crystal thin film formed furthermore on it is 107 seconds when beforehand forming the orientated polycrystal of 100 mol % AlN on the substrate which consists of a same sintered compact which comprises a zinc oxide as the main ingredients and contains a aluminum ingredient, so the crystallinity improved.

While the half width of the rocking curve of the X ray diffraction line from the lattice plane of the Miller Index (002) of the 100 mol % AlN single crystal thin film directly formed on this substrate is 159 seconds when using the substrate which consists of a sintered compact which comprises a zinc oxide as the main ingredients and contains an aluminum ingredient 0.008 mol % by Al₂O₃ conversion, the half width of the rocking curve of the X ray diffraction line from the lattice plane of the Miller Index (002) of the 100 mol % AlN single crystal thin film formed furthermore on it is 97 seconds when beforehand forming the orientated polycrystal of 100 mol % AlN on the substrate which consists of a same sintered compact which comprises a zinc oxide as the main ingredients and contains a aluminum ingredient, so it became not more than 100 seconds.

Following, when using the substrate which consists of a sintered compact which comprises a zinc oxide as the main ingredients and contains an aluminum ingredient in the range of 0.005 mol %-45.0 mol % by Al₂O₃ conversion, if the thin film which consists of various crystallized state, such as an amorphous state, a polycrystal, an orientated polycrystal, and a single crystal etc., and comprises as the main ingredients at least one or more materials selected from a gallium nitride, an indium nitride, and an aluminum nitride is formed beforehand on this substrate and the single crystal thin film which comprises as the main ingredients at least one or more materials selected from a gallium nitride, an indium nitride, and an aluminum nitride is formed furthermore on it, what is the crystallinity superior to the crystallinity of the single crystal thin film which is directly formed on this substrate and comprises as the main ingredients at least one or more materials selected from a gallium nitride, an indium nitride, and an aluminum nitride is obtained, as for the crystallinity of this single crystal thin film, the half width of the rocking curve of the X ray diffraction line from the lattice plane of the Miller Index (002) of this single crystal thin film is in the range of 86 seconds-97 seconds, it was confirmed that it is not more than 100 seconds altogether.

While the half width of the rocking curve of the X ray diffraction line from the lattice plane of the Miller Index (002) of this single crystal thin film is 229 seconds in the case of the 100 mol % AlN single crystal thin film directly formed on the substrate which consists of a sintered compact which comprises a zinc oxide as the main ingredients and contains an aluminum ingredient 50.0 mol % by Al₂O₃ conversion, it is 134 seconds when it is the 100 mol % AlN single crystal thin film which was formed on the 100 mol % AlN orientated polycrystalline thin film which was formed beforehand on the same substrate, so the crystallinity improved.

As shown, for example in Table 46, while the half width of the rocking curve of the X ray diffraction line from the lattice plane of the Miller Index (002) of the 100 mol % AlN single crystal thin film directly formed on this substrate is 175 seconds when using the substrate which consists of a sintered compact which comprises a zinc oxide as the main ingredients and which contains an aluminum ingredient 0.002 mol % by Al₂O₃ conversion and contains further a yttrium ingredient 0.04 mol % by Y₂O₃ conversion, besides it, the half width of the rocking curve of the X ray diffraction line from the lattice plane of the Miller Index (002) is 107 seconds when it is the 100 mol % AlN single crystal thin film which was formed furthermore on the 100 mol % AlN orientated polycrystalline thin film which was formed beforehand on the substrate which consists of a same sintered compact which comprises a zinc oxide as the main ingredients and contains a aluminum ingredient and yttrium, so the crystallinity improved.

When using the substrate which consists of a sintered compact which comprises a zinc oxide as the main ingredients and which contains an aluminum ingredient 0.008 mol % by Al₂O₃ conversion and contains further a yttrium ingredient 0.04 mol % by Y₂O₃ conversion, besides it, while the half width of the rocking curve of the X ray diffraction line from the lattice plane of the Miller Index (002) of the 100 mol % AlN single crystal thin film directly formed on this substrate is 157 seconds, the half width of the rocking curve of the X ray diffraction line from the lattice plane of the Miller Index (002) is 96 seconds and the crystallinity improved to not more than 100 seconds in the case of the 100 mol % AlN single crystal thin film which was formed furthermore on the 100 mol % AlN orientated polycrystalline thin film which was formed beforehand on the substrate which consists of a same sintered compact which comprises a zinc oxide as the main ingredients and contains a aluminum ingredient and yttrium.

Following, as shown in Table 46, when using the substrate which consists of a sintered compact of various compositions which comprises a zinc oxide as the main ingredients and which contains an aluminum ingredient 0.03 mol %, 0.10 mol %, 0.30 mol %, 1.0 mol %, 3.0 mol %, 10.0 mol %, and 30.0 mol % by Al₂O₃ conversion and contains furthermore any one among an iron ingredient, a chromium ingredient, a yttrium ingredient, a dysprosium ingredient, a holmium ingredient, an erbium ingredient, and a ytterbium ingredient, besides it, as for the crystallinity of a 100 mol % AlN single crystal thin film or a 100 mol % GaN single crystal thin film formed furthermore on the orientated polycrystal of 100 mol % AlN formed beforehand on the substrate which consists of a same sintered compact which comprises a zinc oxide as the main ingredients and contains a aluminum ingredient and contains either among an iron ingredient, a chromium ingredient, a yttrium ingredient, a dysprosium ingredient, a holmium ingredient, an erbium ingredient, and a ytterbium ingredient besides it, it improves more than the crystallinity of a 100 mol % AlN single crystal thin film or a 100 mol % GaN single crystal thin film directly formed on each of these substrates, it was confirmed that all the half width of the rocking curve of the X ray diffraction line from the lattice plane of the Miller Index (002) of this single crystal thin film is not more than 100 seconds.

While the half width of the rocking curve of the X ray diffraction line from the lattice plane of the Miller Index (002) of the 100 mol % AlN single crystal thin film directly formed on this substrate is 116 seconds when using the substrate and which consists of a sintered compact which comprises a zinc oxide as the main ingredients and which contains an aluminum ingredient 3.0 mol % by Al₂O₃ conversion and contains further a yttrium ingredient 0.04 mol % by Y₂O₃ conversion, and an erbium ingredient 0.04 mol % by Er₂O₃ conversion, besides it, the half width of the rocking curve of the X ray diffraction line from the lattice plane of the Miller Index (002) is 93 seconds, 96 seconds, 87 seconds, respectively, in the case of the 100 mol % AlN single crystal thin film or the 100 mol % GaN single crystal thin film which was formed furthermore on the 100 mol % AlN amorphous thin film, the 100 mol % AlN polycrystalline thin film, and the 100 mol % AlN orientated polycrystalline thin film which were formed beforehand on the substrate which consists of a same sintered compact which comprises a zinc oxide as the main ingredients and contains a aluminum ingredient, yttrium ingredient, and erbium ingredient.

In addition to this, even when the substrate which consists of a sintered compact of all compositions which comprises a zinc oxide as the main ingredients and is shown in Table 45 and 46 is used, if the single crystal thin film which comprises as the main ingredients at least one or more materials selected from a gallium nitride, an indium nitride, and an aluminum nitride is formed furthermore on it after beforehand forming the thin film which consists of various crystallized state, such as an amorphous state, a polycrystal, an orientated polycrystal, and a single crystal etc., and comprises as the main ingredients at least one or more materials selected from a gallium nitride, an indium nitride, and an aluminum nitride on this substrate, the thing whose crystallinity is superior to the crystallinity of the single crystal thin film which was directly formed on this substrate and comprises as the main ingredients at least one or more materials selected from a gallium nitride, an indium nitride, and an aluminum nitride is obtained.

For example, as shown in Table 45, while the half width of the rocking curve of the X ray diffraction line from the lattice plane of the Miller Index (002) of the 100 mol % AlN single crystal thin film directly formed on this substrate is 227 seconds when the substrate which consists of a sintered compact which comprises a zinc oxide as the main ingredients and contains an iron ingredient 1.0 mol % by Fe₂O₃ conversion excluding an aluminum ingredient was used, the half width of the rocking curve of the X ray diffraction line from the lattice plane of the Miller Index (002) is 124 seconds in the case of the 100 mol % AlN single crystal thin film which was formed furthermore on the 100 mol % AlN orientated polycrystalline thin film which was formed beforehand on the substrate which consists of a same sintered compact which comprises a zinc oxide as the main ingredients and contains a iron ingredient, the crystallinity improved.

While the half width of the rocking curve of the X ray diffraction line from the lattice plane of the Miller Index (002) of the 100 mol % GaN single crystal thin film directly formed on this substrate is 220 seconds when the substrate which consists of a sintered compact which comprises a zinc oxide as the main ingredients and contains a chromium ingredient 1.0 mol % by Cr₂O₃ conversion excluding an aluminum ingredient was used, the half width of the rocking curve of the X ray diffraction line from the lattice plane of the Miller Index (002) is 119 seconds in the case of the 100 mol % GaN single crystal thin film which was formed furthermore on the 100 mol % AlN orientated polycrystalline thin film which was formed beforehand on the substrate which consists of a same sintered compact which comprises a zinc oxide as the main ingredients and contains a chromium ingredient, the crystallinity improved.

While the half width of the rocking curve of the X ray diffraction line from the lattice plane of the Miller Index (002) of the 100 mol % AlN single crystal thin film directly formed on this substrate is 192 seconds when the substrate which consists of a sintered compact which comprises a zinc oxide as the main ingredients and contains a yttrium ingredient 0.04 mol % by Y₂O₃ conversion excluding an aluminum ingredient was used, the half width of the rocking curve of the X ray diffraction line from the lattice plane of the Miller Index (002) is 104 seconds in the case of the 100 mol % AlN single crystal thin film which was formed furthermore on the 100 mol % AlN orientated polycrystalline thin film which was formed beforehand on the substrate which consists of a same sintered compact which comprises a zinc oxide as the main ingredients and contains a yttrium ingredient, the crystallinity improved.

While the half width of the rocking curve of the X ray diffraction line from the lattice plane of the Miller Index (002) of the 100 mol % GaIN single crystal thin film directly formed on this substrate is 206 seconds when the substrate which consists of a sintered compact which comprises a zinc oxide as the main ingredients and contains an erbium ingredient 0.04 mol % by Er₂O₃ conversion excluding an aluminum ingredient was used, the half width of the rocking curve of the X ray diffraction line from the lattice plane of the Miller Index (002) is 107 seconds in the case of the 100 mol % GaN single crystal thin film which was formed furthermore on the 100 mol % AlN orientated polycrystalline thin film which was formed beforehand on the substrate which consists of a same sintered compact which comprises a zinc oxide as the main ingredients and contains a erbium ingredient, the crystallinity improved.

While the half width of the rocking curve of the X ray diffraction line from the lattice plane of the Miller Index (002) of the 100 mol % AlN single crystal thin film directly formed on this substrate is 203 seconds when the substrate which consists of a sintered compact which comprises a zinc oxide as the main ingredients and contains a ytterbium ingredient 0.04 mol % by Yb₂O₃ conversion excluding an aluminum ingredient was used, the half width of the rocking curve of the X ray diffraction line from the lattice plane of the Miller Index (002) is 109 seconds in the case of the 100 mol % AlN single crystal thin film which was formed furthermore on the 100 mol % AlN orientated polycrystalline thin film which was formed beforehand on the substrate which consists of a same sintered compact which comprises a zinc oxide as the main ingredients and contains a ytterbium ingredient, the crystallinity improved.

In the other, the thin film of a different constitution from the thing which is indicated in Table 45 and Table 46 was formed at the substrate which consists of a sintered compact of various compositions which comprises a zinc oxide as the main ingredients and which was produced in this Example and is shown in Table 45 and Table 46.

That is, as mentioned above, the thin film of 100 mol % AlN is formed beforehand in the thickness of 3 μm on the substrate which consists of a sintered compact of various compositions which comprises a zinc oxide as the main ingredients and which is shown in Table 45 and Table 46 by the same conditions as the sputtering method performed in experiment No. 706, 707, and 708 of Example 25 and the MOCVD method performed in experiment No. 709, and the thin film which comprises an aluminum nitride as the main ingredients and is the state of an amorphous state, a polycrystal, an orientated polycrystal, and a single crystal which are respectively same as Example 25 was formed.

The thin film of 100 mol % GaN was formed beforehand in the thickness of 3 Jim by the same conditions as the MOCVD method performed in experiment No. 728 and 730, and the thin film which comprises a gallium nitride as the main ingredients and is the state of an amorphous state and an orientated polycrystal which are respectively same as Example 25 was formed.

The thin film of 100 mol % InN was formed beforehand in the thickness of 3 gm by the same conditions as the MOCVD method performed in experiment No. 731, and the thin film which comprises an indium nitride as the main ingredients and is the same orientated polycrystalline state as Example 25 was formed.

Moreover, using the above mentioned substrate which consists of a sintered compact which comprises a zinc oxide as the main ingredients and formed beforehand the thin film which comprises an aluminum nitride as the main ingredients, the thin film which comprises a gallium nitride as the main ingredients, and the thin film which comprises an indium nitride as the main ingredients, and the substrate which consists of a sintered compact which comprises a zinc oxide as the main ingredients and which was left without forming a thin film, the single crystal thin films of each composition of 100 mol % AlN, 100 mol % GaN, 100 mol % InN, 50 mol % AlN+50 mol % GaN, and 50 mol % GaN+50 mol % InN were formed furthermore on it in the thickness of 3 μm by the same MOCVD method as what was described in Example 19.

Even when the above-mentioned thin film is formed on the substrate which consists of a sintered compact of various compositions which comprises a zinc oxide as the main ingredients and which was produced in this Example in a different constitution from what was shown in Table 45 and Table 46, as for the single crystal thin film formed furthermore on it after beforehand forming the thin film which comprises as the main ingredients at least one or more materials selected from a gallium nitride, an indium nitride, and an aluminum nitride and has various crystallized state, such as an amorphous state, a polycrystal, an orientated polycrystal, and a single crystal etc., it was confirmed that the crystallinity is superior to the crystallinity of the single crystal thin film which comprises as the main ingredients at least one or more materials selected from a gallium nitride, an indium nitride, and an aluminum nitride and which was directly formed on the same substrate which consists of a sintered compact which comprises a zinc oxide as the main ingredients.

Thus, in this Example, when the substrate which consists of a sintered compact which comprises a zinc oxide as the main ingredients is used, as for the crystallinity of the single crystal thin film which comprises as the main ingredients at least one or more materials selected from a gallium nitride, an indium nitride, and an aluminum nitride and is formed furthermore on it after beforehand forming the thin film which comprises as the main ingredients at least one or more materials selected from a gallium nitride, an indium nitride, and an aluminum nitride and has various crystallized state, such as an amorphous state, a polycrystal, an orientated polycrystal, and a single crystal etc., on this substrate, it was confirmed that the thing which is superior to the crystallinity of the single crystal thin film which was directly formed on this substrate and comprises as the main ingredients at least one or more materials selected from a gallium nitride and an aluminum nitride is obtained in all experiments.

In this Example, although the appearance of the thin film of a constitution of having indicated in Table 45 and Table 46 and all the thin films produced in addition to this was investigated, defects, such as a crack and a crevice, are not seen in all the thin films formed beforehand on the substrate and the thin films formed furthermore on it.

Although the exfoliation test by pressure sensitive adhesive tape was performed, in all thin films, exfoliation was not seen between the substrates which consists of a sintered compact which comprises a zinc oxide as the main ingredients, and between thin films.

Although the thin film conductivity material of Ti/Pt/Au was formed on the thin film of the surface of a substrate, the metal lead was soldered and perpendicular tensile strength was investigated, it all is not less than 2 Kg/mm², so it has joined firmly between the sintered compact which comprises a zinc oxide as the main ingredients and the thin film formed beforehand on this substrate, and between this thin film and the thin film formed furthermore on it.

### EXAMPLE 31

This Example shows the example which investigated the composition of this substrate and the influence which gives to the crystallinity of the thin film which is formed on this substrate and comprises as the main ingredients a gallium nitride, an indium nitride, and an aluminum nitride, when the sintered compact which comprises a beryllium oxide as the main ingredients is used as a substrate.

First, what is 99% of purity by Kojundo Chemical Laboratory Co., Ltd. used in Example 1 as beryllium oxide (BeO) powder was prepared, what is 99.99% of purity by Kojundo Chemical Laboratory Co., Ltd. was prepared as magnesia (MgO) powder, what is 99.99% of purity by Kojundo Chemical Laboratory Co., Ltd. was prepared as calcium carbonate (CaCO₃) powder, the “SO-E2” grade of 99.9% of purity made by Admatechs Corp. was prepared as silica (SiO₂) powder.

It pulverized and mixed by a ball mill so that it may become predetermined composition about such powders by the same method as Example 1, then paraffine wax was added and the powder for molding was produced, it degreased after a uniaxial press molding to the powder compact of the same size as Example 1, it carried out the normal pressure sintering at 1500 degrees C. for 3 hours in air after that, the sintered compact which comprises a beryllium oxide as the main ingredients and contains a magnesium ingredient, a calcium ingredient, and a silicon ingredient in a various rate was produced.

Each of these sintered compacts was made dense to not less than 98% of relative density.

Specular surface polish was carried out using the abradant which comprises as the main ingredients the colloidal alumina of particle diameter of 0.05 μm like Example 8, ultrasonic washing of the obtained sintered compact was carried out by methylene chloride and IPA, and the substrate was produced.

Average surface roughness Ra of the substrate which carried out specular surface polish was in the range of 8.6 nm-9.5 nm.

The optical transmissivity to the light of 605 nm wavelength was measured by the same method as Example 2 using the substrate after polish.

Thus, the characteristic of the obtained substrate which consists of a sintered compact which comprises a beryllium oxide as the main ingredients is shown in Table 47.

Although the optical transmissivity of the sintered compact which consists only of a beryllium oxide substantially, and in which anything other than the impurities in a raw material are not contained by being fired without adding a magnesium ingredient, a calcium ingredient, a silicon ingredient, and other ingredients was 14% to the light of 605 nm wavelength, the tendency of which optical transmissivity also rises is shown according as the content of a magnesium ingredient, a calcium ingredient, and a silicon ingredient increases, it reached to 57% in what contains a calcium ingredient 0.45 mol % by CaO conversion.

After that, the optical transmissivity lowers gradually according as the content of a magnesium ingredient, a calcium ingredient, and a silicon ingredient increases, the optical transmissivity to the light of 605 nm wavelength becomes 24% in the sintered compact which comprises a beryllium oxide as the main ingredients an contains a magnesium ingredient 30.0 mol % by MgO conversion, the optical transmissivity became 7.6% in the sintered compact which comprises a beryllium oxide as the main ingredients and contains a magnesium ingredient 40.0 mol % by MgO conversion.

In this Example, as for the sintered compact which comprises a beryllium oxide as the main ingredients and which contains at least one or more of a magnesium ingredient, a calcium ingredient, and a silicon ingredient, in the range of not more than 35.0 mol % in total by oxide conversion and contains furthermore at least one or more ingredients selected from the rare earth elements in the range of 0.00005 mol %-5.0 mol % in total by oxide conversion, it was confirmed that the thing which is not less than 30% as optical transmissivity to the light of 605 nm wavelength is easy to be obtained.

Furthermore, it was also confirmed that the sintered compact which has the optical transmissivity not less than 80% and comprises a beryllium oxide as the main ingredients can manufacture.

That is, as shown in Table 47, as for the sintered compact which comprises a beryllium oxide as the main ingredients and which contains a calcium ingredient 0.0004 mol % by CaO conversion and contains simultaneously a yttrium ingredient 0.0002 mol % by Y₂O₃ conversion, the optical transmissivity was 35% to the light of 605 nm wavelength.

After that, optical transmissivity shows the increasing tendency according as a yttrium ingredient increases, as for the sintered compact which comprises a beryllium oxide as the main ingredients and which contains a calcium ingredient 0.45 mol % by CaO conversion and contains simultaneously a yttrium ingredient 0.040 mol % by Y₂O₃ conversion, the optical transmissivity was 81% to the light of 605 nm wavelength.

Furthermore, after that, optical transmissivity shows the tendency to lower according as a yttrium ingredient increases, as for the sintered compact which comprises a beryllium oxide as the main ingredients and which contains a calcium ingredient 0.0004 mol % by CaO conversion and contains simultaneously a yttrium ingredient 4.0 mol % by Y₂O₃ conversion, the optical transmissivity was 37% to the light of 605 nm wavelength, as for the sintered compact which comprises a beryllium oxide as the main ingredients and which contains a calcium ingredient 0.0004 mol % by CaO conversion and contains simultaneously a yttrium ingredient 6.0 mol % by Y₂O₃ conversion, the optical transmissivity was 28% to the light of 605 nm wavelength.

Furthermore, as mentioned above, the optical transmissivity of the sintered compact which comprises a beryllium oxide as the main ingredients and which contains a calcium ingredient 0.45 mol % by CaO conversion and contains further a yttrium ingredient 0.040 mol % by Y₂O₃ conversion was 81% to the light of 605 nm wavelength, the optical transmissivity of the sintered compact which comprises a beryllium oxide as the main ingredients and which contains a calcium ingredient 0.45 mol % by CaO conversion and contains further a rare earth element ingredient other than yttrium by oxide conversion was also as high as 75%-80% to the light of 605 nm wavelength.

That is, the optical transmissivity of the sintered compact which comprises a beryllium oxide as the main ingredients and which contains a calcium ingredient 0.45 mol % by CaO conversion and contains as a rare earth element ingredient further a dysprosium ingredient 0.040 mol % by Dy₂O₃ conversion simultaneously was 76% to the light of 605 nm wavelength, the optical transmissivity of the sintered compact which comprises a beryllium oxide as the main ingredients and contains simultaneously a holmium ingredient 0.040 mol % by Ho₂O₃ conversion was 75%, the optical transmissivity of the sintered compact which comprises a beryllium oxide as the main ingredients and contains simultaneously an erbium ingredient 0.040 mol % by Er₂O₃ conversion was 80%, the optical transmissivity of the sintered compact which comprises a beryllium oxide as the main ingredients and contains simultaneously a ytterbium ingredient 0.040 mol % by Yb₂O₃ conversion was 78%.

Furthermore, as for the sintered compact which comprises a beryllium oxide as the main ingredients and contains simultaneously three ingredients of a calcium ingredient of 0.45 mol % by CaO conversion, a silicon ingredient of 0.20 mol % by SiO₂ conversion, and a yttrium ingredient of 0.040 mol % by Y₂O₃ conversion, the optical transmissivity to the light with a wavelength 605 nm was 80%.

Next, the thin film was formed by the same method as what was shown in Example 27 to the prepared above-mentioned substrate.

That is, after choosing a part of prepared substrate the thin film of a 100 mol % AlN was formed beforehand on it in the thickness of 3 μm according to the same conditions as the sputtering method which was performed in experiment No. 708 of Example 25.

Next, using the above mentioned substrate which consists of a sintered compact which comprises a beryllium oxide as the main ingredients and which formed beforehand an AlN thin film and the substrate which consists of a sintered compact which comprises a beryllium oxide as the main ingredients and which was left without forming an AlN thin film, the thin films of each composition of the same 100 mol % AlN and 100 mol % GaN as what was described in Example in Example 19 were formed furthermore on it in the thickness of 3 μm by the MOCVD method.

They were the same conditions as Example 1 and Example 2 like a description in Example 19 as conditions of MOCVD.

Thus, the characteristic of the thin film produced like that was shown in Table 47.

In this Example, in the 100 mol % AlN thin film formed beforehand on each above-mentioned substrate, only the diffraction line from the lattice plane of a Miller Index (002) had appeared, it was clearly the orientated polycrystal formed in the direction where C axis is perpendicular to the substrate surface.

When the substrate which consists of a sintered compact which comprises a beryllium oxide as the main ingredients and which does not contain a magnesium ingredient, a calcium ingredient, and a silicon ingredient substantially was used as shown in Table 47, if the crystallinity of the AlN orientated polycrystalline thin film formed beforehand on each above-mentioned substrate was seen, the half width of the rocking curve of the X ray diffraction line from the lattice plane of the Miller Index (002) of this orientated polycrystalline thin film was 9670 seconds.

The crystallinity of this orientated polycrystalline thin film showed the tendency to improve according as the magnesium ingredient, the calcium ingredient, and the silicon ingredient increase.

That is, although it was 9120 seconds when the substrate which consists of a sintered compact which comprises a beryllium oxide as the main ingredients and contains a magnesium ingredient 0.0001 mol % by MgO conversion was used, it was 8540 seconds when the substrate which consists of a sintered compact which comprises a beryllium oxide as the main ingredients and contains a calcium ingredient 0.0004 mol % by CaO conversion was used, it was 7710 seconds and lowered into not more than 8000 seconds when the substrate which consists of a sintered compact which comprises a beryllium oxide as the main ingredients and contains a silicon ingredient 0.002-mol % by SiO₂ conversion.

After that, the crystallinity of this AlN orientated polycrystalline thin film showed the tendency to improve a little according as the content of a magnesium ingredient, a calcium ingredient, and a silicon ingredient increases.

When the substrate which consists of a sintered compact which comprises a beryllium oxide as the main ingredients and which contains a calcium ingredient 0.45 mol % by CaO conversion, and a silicon ingredient 0.2 mol % by SiO₂ conversion was used, it became 7190 seconds and it has been improved most.

The tendency for the crystallinity of this AlN orientated polycrystalline thin film to lower a little was shown according as the content of a magnesium ingredient, a calcium ingredient, and a silicon ingredient increases after that.

In the case of the AlN orientated polycrystalline thin film which was formed on the substrate which consists of a sintered compact which comprises a beryllium oxide as the main ingredients and contains a magnesium ingredient 30.0 mol % by MgO conversion, it was 7650 seconds.

However, in the case of the AlN orientated polycrystalline thin film which was formed on the substrate which consists of a sintered compact which comprises a beryllium oxide as the main ingredients and contains a magnesium ingredient 40.0 mol % by MgO conversion, it was 9480 seconds and the crystallinity fell.

In the case of the AlN orientated polycrystalline thin film formed on the substrate which consists of a sintered compact which comprises a beryllium oxide as the main ingredients and which contains at least one or more ingredients of a magnesium ingredient, a calcium ingredient, and a silicon ingredient a total of not more than 35.0 mol % by oxide conversion and contains furthermore at least one or more ingredients selected from rare earth elements, the half width of the rocking curve of the X ray diffraction line from the lattice plane of the Miller Index (002) of this orientated polycrystalline thin film was in the range of 7220 seconds-7960 seconds, and it was not more than 8000 seconds altogether.

Next, as for the thin film which consists of each composition of 100 mol % AlN and 100 mol % GaN and which was formed by the above-mentioned MOCVD method using the substrate which consists of a sintered compact which comprises a beryllium oxide as the main ingredients and which was left without forming beforehand the above thin film, the crystallinity was investigated by X ray diffraction.

Consequently, it was confirmed that all the produced thin films are the single crystals formed in the direction where C axis is perpendicular to the substrate surface.

If the crystallinity is seen, as for the half width of the rocking curve of the X ray diffraction line from the lattice plane of the Miller Index (002) of the 100 mol % AlN single crystal thin film formed directly on the substrate which consists of a sintered compact which comprises a beryllium oxide as the main ingredients and which does not contain anything other than the impurities substantially mixed in a raw material or at the time of sintered compact manufacture by being fired without adding a magnesium ingredient, a calcium ingredient, a silicon ingredient, and other ingredients as shown in Table 47, it was 270 seconds.

On the other hand, in the case of the 100 mol % AlN single crystal thin film which was directly formed on the substrate which consists of a sintered compact which comprises a beryllium oxide as the main ingredients and contains a magnesium ingredient 0.0001 mol % by MgO conversion, it became small with 221 seconds and crystallinity improved.

Furthermore, that is 191 seconds in the case of the 100 mol % AlN single crystal thin film which was directly formed on the substrate which consists of a sintered compact which comprises a beryllium oxide as the main ingredients and contains a calcium ingredient 0.0004 mol % by CaO conversion, that is 168 seconds in the case of the 100 mol % AlN single crystal thin film which was directly formed on the substrate which consists of a sintered compact which comprises a beryllium oxide as the main ingredients and contains a silicon ingredient 0.0020 mol % by SiO₂ conversion, so it had become not more than 200 seconds, respectively, and crystallinity improved.

That is 142 seconds in the case of the 100 mol % AlN single crystal thin film which was directly formed on the substrate which consists of a sintered compact which comprises a beryllium oxide as the main ingredients and contains a magnesium ingredient 0.0080 mol % by MgO conversion, it has become not more than 150 seconds, and crystallinity improved more.

That is 122 seconds in the case of the 100 mol % AlN single crystal thin film which was directly formed on the substrate which consists of a sintered compact which comprises a beryllium oxide as the main ingredients and contains a calcium ingredient 0.020 mol % by CaO conversion, that is 127 seconds in the case of the 100 mol % AlN single crystal thin film which was directly formed on the substrate which consists of a sintered compact which comprises a beryllium oxide as the main ingredients and contains a silicon ingredient 0.40 mol % by SiO₂ conversion, so it had become not more than 130 seconds, respectively, and crystallinity improved still more.

After that, the half width of the rocking curve of the X ray diffraction line from the lattice plane of the Miller Index (002) of the single crystal thin film directly formed on the substrate which consists of a sintered compact which comprises a beryllium oxide as the main ingredients became small as the content of a magnesium ingredient, a calcium ingredient, and a silicon ingredient increased.

Namely, that is 109 seconds in the case of the 100 mol % AlN single crystal thin film which was directly formed on the substrate which consists of a sintered compact which comprises a beryllium oxide as the main ingredients and contains a calcium ingredient 0.45 mol % by CaO conversion, that is 108 seconds in the case of the 100 mol % AlN single crystal thin film which was directly formed on the substrate which consists of a sintered compact which comprises a beryllium oxide as the main ingredients and contains simultaneously a calcium ingredient of 0.45 mol % by CaO conversion and a silicon ingredient of 0.20 mol % by SiO₂ conversion, it became the smallest in the single crystal thin film directly formed on the substrate in this Example, and crystallinity was most excellent.

After that, the half width of the rocking curve of the X ray diffraction line from the lattice plane of the Miller Index (002) of the single crystal thin film directly formed on the substrate which consists of a sintered compact which comprises a beryllium oxide as the main ingredients becomes large as the content of a magnesium ingredient, a calcium ingredient, and a silicon ingredient increases, it became 132 seconds in the case of the 100 mol % AlN single crystal thin film which was directly formed on the substrate which consists of a sintered compact which comprises a beryllium oxide as the main ingredients and contains a magnesium ingredient 30.0 mol % by MgO conversion,

It became 217 seconds in the case of the 100 mol % AlN single crystal thin film which was directly formed on the substrate which consists of a sintered compact which comprises a beryllium oxide as the main ingredients and contains a magnesium ingredient 40.0 mol % by MgO conversion, it became larger than 200 seconds.

On the other hand, in this Example, as shown in Table 47, in the case of the substrate which consists of a sintered compact which comprises a beryllium oxide as the main ingredients and which contains at least one or more of a magnesium, a calcium, and a silicon ingredient, even if ingredients other than a magnesium, a calcium, and a silicon ingredient, such as a rare earth element, were contained in this sintered compact, it was confirmed that there is little change of lowering greatly the crystallinity of a single crystal thin film which is directly formed on this substrate and which comprises as the main ingredients at least one or more materials selected from a gallium nitride, an indium nitride, and an aluminum nitride.

If saying in other words, in the case of the substrate which consists of a sintered compact which comprises a beryllium oxide as the main ingredients and which contains at least one or more of a magnesium, a calcium, and a silicon ingredient, even if ingredients other than a magnesium, a calcium, and a silicon ingredient, such as a rare earth element, were contained in this sintered compact, it was confirmed that the crystallinity of the single crystal thin film directly formed on this substrate is what cannot be influenced easily by these ingredients.

Concretely saying, as for the half width of the rocking curve of the X ray diffraction line from the lattice plane of the Miller Index (002) of the 100 mol % AlN single crystal thin film directly formed on the substrate which consists of a sintered compact which comprises a beryllium oxide as the main ingredients and contains simultaneously a calcium ingredient o 0.0004 mol % by CaO conversion and a yttrium ingredient of 0.0002 mol % by Y₂O₃ conversion, and a sintered compact which comprises a beryllium oxide as the main ingredients and contains simultaneously a calcium ingredient of 0.0004 mol % by CaO conversion and a yttrium ingredient of 6.0 mol % by Y₂O₃ conversion, it is 182 seconds and 189 seconds, respectively, as for the crystallinity, the change tendency of lowering greatly from 191 seconds of the 100 mol % AlN single crystal thin film directly formed on the substrate which consists of a sintered compact which comprises a beryllium oxide as the main ingredients and which contains only a calcium ingredient 0.0004 mol % by CaO conversion and does not contain a yttrium ingredient substantially was not shown.

The half width of the rocking curve of the X ray diffraction line from the lattice plane of the Miller Index (002) of the 100 mol % GaN single crystal thin film directly formed on the substrate which consists of a sintered compact which comprises a beryllium oxide as the main ingredients and which contains a calcium ingredient 0.0004 mol % by CaO conversion and contains simultaneously a yttrium ingredient 4.0 mol % by Y₂O₃ conversion is 176 seconds, as for the crystallinity, the change tendency of lowering greatly from 191 seconds of the 100 mol % AlN single crystal thin film directly formed on the substrate which consists of a sintered compact which comprises a beryllium oxide as the main ingredients and which contains only a calcium ingredient 0.0004 mol % by CaO conversion and does not contain a yttrium ingredient substantially was not shown.

The half width of the rocking curve of the X ray diffraction line from the lattice plane of the Miller Index (002) of the 100 mol % AlN single crystal thin film directly formed on the substrate which consists of a sintered compact which comprises a beryllium oxide as the main ingredients and which contains a calcium ingredient 0.020 mol % by CaO conversion and contains simultaneously a yttrium ingredient 0.0010 mol % and 0.0040 mol % by Y₂O₃ conversion, respectively, is 121 seconds and 120 seconds, respectively, as for the crystallinity, the change tendency of lowering greatly from 122 seconds of the 100 mol % AlN single crystal thin film directly formed on the substrate which consists of a sintered compact which comprises a beryllium oxide as the main ingredients and which contains only a calcium ingredient 0.020 mol % by CaO conversion and does not contain a yttrium ingredient substantially was not shown.

The half width of the rocking curve of the X ray diffraction line from the lattice plane of the Miller Index (002) of the 100 mol % GaN single crystal thin film directly formed on the substrate which consists of a sintered compact which comprises a beryllium oxide as the main ingredients and which contains a calcium ingredient 0.020 mol % by CaO conversion and contains simultaneously a yttrium ingredient 0.010 mol % by Y₂O₃ conversion is 118 seconds, as for the crystallinity, the change tendency of lowering greatly from 122 seconds of the 100 mol % AlN single crystal thin film directly formed on the substrate which consists of a sintered compact which comprises a beryllium oxide as the main ingredients and which contains only a calcium ingredient 0.020 mol % by CaO conversion and does not contain a yttrium ingredient substantially was not shown.

The half width of the rocking curve of the X ray diffraction line from the lattice plane of the Miller Index (002) of the 100 mol % AlN single crystal thin film directly formed on the substrate which consists of a sintered compact which comprises a beryllium oxide as the main ingredients and which contains a calcium ingredient 0.45 mol % by CaO conversion and contains simultaneously a yttrium ingredient 0.040 mol % by Y₂O₃ conversion, a holmium ingredient 0.040 mol % by Ho₂O₃ conversion, and an erbium ingredient 0.040 mol % by Er₂O₃ conversion, respectively, is 104 seconds, 107 seconds, and 108 seconds, respectively, as for the crystallinity, the change tendency of lowering greatly from 109 seconds of the 100 mol % AlN single crystal thin film directly formed on the substrate which consists of a sintered compact which comprises a beryllium oxide as the main ingredients and which contains only a calcium ingredient 0.45 mol % by CaO conversion and does not contain the above-mentioned various rare earth element ingredients substantially was not shown.

The half width of the rocking curve of the X ray diffraction line from the lattice plane of the Miller Index (002) of the 100 mol % GaN single crystal thin film directly formed on the substrate which consists of a sintered compact which comprises a beryllium oxide as the main ingredients and which contains a calcium ingredient 0.45 mol % by CaO conversion and contains simultaneously a dysprosium ingredient 0.040 mol % by Dy₂O₃ conversion, a ytterbium ingredient 0.040 mol % by Yb₂O₃ conversion, respectively is 110 seconds and 106 seconds, respectively, as for the crystallinity, the change tendency of lowering greatly from 109 seconds of the 100 mol % AlN single crystal thin film directly formed on the substrate which consists of a sintered compact which comprises a beryllium oxide as the main ingredients and which contains only a calcium ingredient 0.45 mol % by CaO conversion and does not contain the above-mentioned various rare earth element ingredients substantially was not shown.

The half width of the rocking curve of the X ray diffraction line from the lattice plane of the Miller Index (002) of the 100 mol % GaN single crystal thin film directly formed on the substrate which consists of a sintered compact which comprises a beryllium oxide as the main ingredients and which contains a calcium ingredient 0.45 mol % by CaO conversion, and a silicon ingredient 0.20 mol % by SiO₂ conversion and contains simultaneously a yttrium ingredient 0.040 mol % by Y₂O₃ conversion is 109 seconds, as for the crystallinity, the change tendency of lowering greatly from 108 seconds of the 100 mol % AlN single crystal thin film directly formed on the substrate which consists of a sintered compact which comprises a beryllium oxide as the main ingredients and which contains only a calcium ingredient 0.45 mol % by CaO conversion, and a silicon ingredient 0.20 mol % by SiO₂ conversion and does not contain a yttrium ingredient substantially was not shown.

Thus, as for the substrate which consists of a sintered compact which comprises a beryllium oxide as the main ingredients and which contains at least one or more materials selected from a magnesium ingredient, a calcium ingredient, and a silicon ingredient, even if these substrates were what consists of a sintered compact which comprises a beryllium oxide as the main ingredients and which contains simultaneously rare earth element ingredients, such as yttrium, other than a magnesium ingredient, a calcium ingredient, and a silicon ingredient, the crystallinity of the single crystal thin film which is directly formed on this substrate and comprises a gallium nitride and an aluminum nitride as the main ingredients changes little, and having the tendency to be hard to be influenced by the existence of rare earth element ingredients, such as a yttrium ingredient, was confirmed.

As mentioned above, the half width of the rocking curve of the X ray diffraction line from the lattice plane of the Miller Index (002) of the 100 mol % AlN single crystal thin film and the 100 mol % GaN single crystal thin film which were directly formed on the substrate which consists of a sintered compact of various compositions which comprises a beryllium oxide as the main ingredients is not more than 300 seconds altogether, it excelled in crystallinity.

In this Example, when the substrate which consists of a sintered compact which comprises a beryllium oxide as the main ingredients and which has various above-mentioned compositions and has such characteristics is used, if the orientated polycrystalline thin film which comprises an aluminum nitride as the main ingredients is formed beforehand on this substrate, and the single crystal thin film which comprises as the main ingredients at least one or more materials selected from a gallium nitride and an aluminum nitride is formed furthermore on it, as for the crystallinity of this single crystal thin film, it was confirmed that the thing which is more excellent in crystallinity than the crystallinity of the single crystal thin film which is directly formed on this substrate and comprises as the main ingredients at least one or more materials selected from a gallium nitride and an aluminum nitride, is obtained.

That is, even if the sintered compact which comprises a beryllium oxide as the main ingredients and has various compositions is used as a substrate, it does not necessarily restrict that half width of the rocking curve of the X ray diffraction line from the lattice plane of a Miller Index (002) of the single crystal thin film which comprises as the main ingredients at least one or more materials selected from a gallium nitride and an aluminum nitride which are directly formed on this substrate becomes not more than 200 seconds.

On the other hand, even if it uses as a substrate the sintered compact which comprises a beryllium oxide as the main ingredients and has such various composition, if the orientated polycrystalline thin film which comprises an aluminum nitride as the main ingredients is formed beforehand on this substrate and the single crystal thin film which comprises as the main ingredients at least one or more materials selected from a gallium nitride and an aluminum nitride is formed furthermore on it, it was confirmed that the thing which is not more than 200 seconds can be formed as half width of the rocking curve of the X ray diffraction line from the lattice plane of the Miller Index (002) of this single crystal thin film.

When the single crystal thin film which comprises as the main ingredients at least one or more materials selected from a gallium nitride and an aluminum nitride is formed using the substrate which consists of a sintered compact which has the same composition and comprises a beryllium oxide as the main ingredients, if the orientated polycrystalline thin film which comprises an aluminum nitride as the main ingredients is formed beforehand on this substrate, and the single crystal thin film which comprises as the main ingredients at least one or more materials selected from a gallium nitride and an aluminum nitride is formed furthermore on it, as for the crystallinity of this single crystal thin film, it was confirmed that the thing which is more excellent in crystallinity than the crystallinity of the single crystal thin film which is directly formed on this substrate and comprises as the main ingredients at least one or more materials selected from a gallium nitride and an aluminum nitride is obtained.

That is, by using the substrate which consists of a sintered compact which comprises a beryllium oxide as the main ingredients and which contains at least one or more of a magnesium ingredient, a calcium ingredient, and a silicon ingredient in the range of 0.0002 mol %-35.0 mol % in total by oxide conversion, if the orientated polycrystalline thin film which comprises an aluminum nitride as the main ingredients is formed beforehand on it, and the single crystal thin film which comprises as the main ingredients at least one or more materials selected from a gallium nitride and an aluminum nitride is formed furthermore on it, the half width of the rocking curve of the X ray diffraction line from the lattice plane of the Miller Index (002) of this single crystal thin film tends to become what is excellent in crystallinity not more than 130 seconds, using the substrate which consists of a sintered compact which comprises a beryllium oxide as the main ingredients and which contains at least one or more of a magnesium ingredient, a calcium ingredient, and a silicon ingredient in the range of 0.001 mol %-35.0 mol % in total by oxide conversion, if the orientated polycrystalline thin film which comprises an aluminum nitride as the main ingredients is formed beforehand on it, and the single crystal thin film which comprises as the main ingredients at least one or more materials selected from a gallium nitride and an aluminum nitride is formed furthermore on it, it was confirmed that the thing which is excellent in crystallinity not more than 100 seconds can be formed comparatively easily as half width of the rocking curve of the X ray diffraction line from the lattice plane of the Miller Index (002) of this single crystal thin film.

Even if it is the substrate which consists of a sintered compact which comprises a beryllium oxide as the main ingredients and which contains the above amount of a magnesium ingredient, a calcium ingredient, and a silicon ingredient, and besides these, and contains simultaneously ingredients, such as a yttrium ingredient, a dysprosium ingredient, a holmium ingredient, an erbium ingredient, and a ytterbium ingredient, etc., as for the crystallinity of the single crystal thin film formed on this substrate, it was confirmed that it is hard to receive change of reducing greatly if it is compared with the crystallinity of a single crystal thin film formed on the substrate which consists of a sintered compact which comprises a beryllium oxide as the main ingredients and which contains the above-mentioned magnesium ingredient, a calcium ingredient, and a silicon ingredient, and does not contain substantially ingredients, such as a yttrium ingredient, a dysprosium ingredient, a holmium ingredient, an erbium ingredient, and a ytterbium ingredient, etc. other than these.

That is, if it is the substrate which consists of a sintered compact which comprises a beryllium oxide as the main ingredients and which contains ingredients of the above amount of at least one or more materials selected from a magnesium ingredient, a calcium ingredient, and a silicon ingredient, even if ingredients other than a magnesium ingredient, a calcium ingredient, and a silicon ingredient, such as a yttrium ingredient, a dysprosium ingredient, a holmium ingredient, an erbium ingredient, and a ytterbium ingredient, were contained, it was confirmed that the crystallinity of the formed single crystal thin film which comprises as the main ingredients at least one or more materials selected from a gallium nitride and an aluminum nitride is what cannot be influenced easily by these ingredients. The beryllium oxide which has silicon ingredients

More concretely saying, as shown in Table 47, while the half width of the 100 mol % AlN single crystal thin film directly formed on the substrate which consists of a sintered compact which comprises a beryllium oxide as the main ingredients and does not contain anything other than the impurities substantially mixed in a raw material or at the time of sintered compact manufacture by being fired without adding a magnesium ingredient, a calcium ingredient, a silicon ingredient, and other ingredients was 270seconds, the half width of the rocking curve of the X ray diffraction line from the lattice plane of the Miller Index (002) of the 100 mol % AlN single crystal thin film which was formed furthermore on the 100 mol % AlN orientated polycrystalline thin film which was formed beforehand on the substrate which consists of a same sintered compact which comprises a beryllium oxide as the main ingredients is 139 seconds, the crystallinity improved.

While the half width of the rocking curve of the X ray diffraction line from the lattice plane of the Miller Index (002) of the 100 mol % AlN single crystal thin film directly formed on this substrate is 221 seconds when the substrate which consists of a sintered compact which comprises a beryllium oxide as the main ingredients and contains a magnesium ingredient 0.0001 mol % by MgO conversion is used, the half width of the rocking curve of the X ray diffraction line from the lattice plane of the Miller Index (002) of the 100 mol % AlN single crystal thin film which was formed furthermore on the 100 mol % AlN orientated polycrystalline thin film which was formed beforehand on the substrate which consists of a same sintered compact which comprises a beryllium oxide as the main ingredients and contains a magnesium ingredient is 132 seconds, the crystallinity improved.

Furthermore, while the half width of the rocking curve of the X ray diffraction line from the lattice plane of the Miller Index (002) of the 100 mol % AlN single crystal thin film directly formed on this substrate is 191 seconds when the substrate which consists of a sintered compact which comprises a beryllium oxide as the main ingredients and contains a calcium ingredient 0.0004 mol % by CaO conversion is used, the half width of the rocking curve of the X ray diffraction line from the lattice plane of the Miller Index (002) of the 100 mol % AlN single crystal thin film which was formed furthermore on the 100 mol % AlN orientated polycrystalline thin film which was formed beforehand on the substrate which consists of a same sintered compact which comprises a beryllium oxide as the main ingredients and contains a calcium ingredient is 124 seconds, the crystallinity improved.

While the half width of the rocking curve of the X ray diffraction line from the lattice plane of the Miller Index (002) of the 100 mol % AlN single crystal thin film directly formed on this substrate is 168 seconds when the substrate which consists of a sintered compact which comprises a beryllium oxide as the main ingredients and contains a silicon ingredient 0.002 mol % by SiO₂ conversion is used, the half width of the rocking curve of the X ray diffraction line from the lattice plane of the Miller Index (002) of the 100 mol % AlN single crystal thin film which was formed furthermore on the 100 mol % AlN orientated polycrystalline thin film which was formed beforehand on the substrate which consists of a same sintered compact which comprises a beryllium oxide as the main ingredients and contains a silicon ingredient is 96 seconds, so it became not more than 100 seconds.

Following, when the substrate which consists of a sintered compact which comprises a beryllium oxide as the main ingredients and which contains at least one or more materials selected from a magnesium ingredient, a calcium ingredient, and a silicon ingredient in the range of 0.001 mol %-35.0 mol % in total by oxide conversion is used, as for the crystallinity of the single crystal thin film which comprises as the main ingredients at least one or more materials selected from a gallium nitride and an aluminum nitride and is formed furthermore on it after beforehand forming the orientated polycrystalline thin film which comprises an aluminum nitride as the main ingredients, the thing superior to the crystallinity of the single crystal thin film which comprises as the main ingredients at least one or more materials selected from a gallium nitride and an aluminum nitride and was directly formed on this substrate can be obtained, the half width of the rocking curve of the X ray diffraction line from the lattice plane of the Miller Index (002) of this single crystal thin film is the range which is 89 seconds-97 seconds, and it was confirmed that all are not more than 100 seconds.

While the half width of the rocking curve of the X ray diffraction line from the lattice plane of the Miller Index (002) of this single crystal thin film is 217 seconds in the case of the 100 mol % AlN single crystal thin film which was directly formed on the substrate which consists of a sintered compact which comprises a beryllium oxide as the main ingredients and contains a magnesium ingredient 40.0 mol % by MgO conversion, that is 142 seconds in the case of 100 mol % AlN single crystal thin film which was formed furthermore on the 100 mol % AlN orientated polycrystalline thin film was formed beforehand on the same substrate, the crystallinity improved.

For example, as shown in Table 47, when the substrate which consists of a sintered compact which comprises a beryllium oxide as the main ingredients and which contains at least one or more ingredients selected from magnesium, calcium, and silicon and furthermore contains a rare-earth-elements ingredient was used, as for the crystallinity of the 100 mol % AlN single crystal thin film or 100 mol % GaN single crystal thin film which was formed furthermore on it after beforehand forming the orientated polycrystalline thin film of 100 mol % AlN on the substrate which consists of a same sintered compact which comprises a beryllium oxide as the main ingredients and which contains at least one or more ingredients selected from magnesium, calcium, and silicon and contains further a rare-earth-elements ingredient simultaneously, it was confirmed that it improves than the crystallinity of the 100 mol % AlN single crystal thin film or 100 mol % GaN single crystal thin film which were directly formed on this substrate.

For example, while the half width of the rocking curve of the X ray diffraction line from the lattice plane of the Miller Index (002) of the 100 mol % AlN single crystal thin film or the 100 mol % GaN single crystal thin film which were directly formed on this substrate is 182 seconds, 176 seconds, and 189 seconds in each substrate when using the substrate which consists of a sintered compact which comprises a beryllium oxide as the main ingredients and which contains a calcium ingredient 0.0004 mol % by CaO conversion and contains further a yttrium ingredient 0.0002 mol %, 4.0 mol %, and 6.0 mol % by Y₂O₃ conversion besides it, the half width of the rocking curve of the X ray diffraction line from the lattice plane of the Miller Index (002) of a 100 mol % AlN single crystal thin film or a 100 mol % GaN single crystal thin film which was formed furthermore on it after beforehand forming the orientated polycrystalline thin film of 100 mol % AlN on the substrate which consists of a same sintered compact which comprises a beryllium oxide as the main ingredients and contains a calcium ingredient and a yttrium ingredient is 119 seconds, 121 seconds, and 126 seconds in each substrate, its crystallinity improved.

Moreover, when what formed beforehand the 100 mol % AlN orientated polycrystalline thin film on the substrate which consists of a sintered compact which comprises a beryllium oxide as the main ingredients and which contains a calcium ingredient 0.020 mol % by CaO conversion and contains further a yttrium ingredient 0.0010 mol %, 0.0040 mol %, and 0.010 mol % by Y₂O₃ conversion, besides it, was used, the half width of the rocking curve of the X ray diffraction line from the lattice plane of the Miller Index (002) of the 100 mol % AlN single crystal thin film or the 100 mol % GaN single crystal thin film which was formed on that is 93 seconds, 94 seconds, and 92 seconds, respectively, they were not more than 100 seconds, the crystallinity improved than what was directly formed on the same substrate.

When what formed beforehand the 100 mol % AlN orientated polycrystalline thin film on the substrate which consists of a sintered compact which comprises a beryllium oxide as the main ingredients and which has a composition which contains a calcium ingredient 0.45 mol % by CaO conversion and contains further a yttrium ingredient 0.040 mol % by Y₂O₃ conversion, a dysprosium ingredient 0.040 mol % by Dy₂O₃ conversion, a holmium ingredient 0.040 mol % by Ho₂O₃ conversion, an erbium ingredient 0.040 mol % by Er₂O₃ conversion, and a ytterbium ingredient 0.040 mol % by Yb₂O₃ conversion, respectively, besides it, was used, the half width of the rocking curve of the X ray diffraction line from the lattice plane of the Miller Index (002) of the 100 mol % AlN single crystal thin film or the 100 mol % GaN single crystal thin film which was formed on that is 88 seconds, 91 seconds, 90 seconds, 89 seconds, and 90 seconds, respectively, it was not more than 100 seconds altogether, the crystallinity improved than what was directly formed on the same substrate.

It is although not indicated in Table 47, on the substrate which consists of a sintered compact of various compositions which comprises a beryllium oxide as the main ingredients and which is shown in Table 47 and was produced in this Example, not only a 100 mol % AlN orientated polycrystalline thin film but also the thin film of a 100 mol % AlN is formed beforehand in the thickness of 3 μm by the same conditions as the MOCVD method performed in experiment No. 709 and the sputtering method performed in experiment No. 706 and 707 of Example 25, the thin film which comprises an aluminum nitride as the main ingredients and which is same as Example 25 and is an amorphous state, a polycrystalline state, and a single crystal state was formed, respectively.

The thin film of a 100 mol % GaN was formed beforehand in the thickness of 3 [m according to the same conditions as the MOCVD method which was performed in experiment No. 728 and 730, and the thin film which comprises a gallium nitride as the main ingredients and which is same as Example 25 and is an amorphous state, and an orientated polycrystal was formed, respectively.

The thin film of a 100 mol % InN was formed beforehand in the thickness of 3 Jim according to the same conditions as the MOCVD method which was performed in experiment No. 731, and the thin film which comprises an indium nitride as the main ingredients and is the same orientated polycrystalline state as Example 25 was formed.

Moreover, using the above mentioned substrate which consists of a sintered compact which comprises a beryllium oxide as the main ingredients and formed beforehand the thin film which comprises an aluminum nitride as the main ingredients, the thin film which comprises a gallium nitride as the main ingredients, and the thin film which comprises an indium nitride as the main ingredients, and the substrate which consists of a sintered compact which comprises a beryllium oxide as the main ingredients and which was left without forming a thin film, the single crystal thin films of each composition of 100 mol % AlN, 100 mol % GaN, 100 mol % InN, 50 mol % AlN+50 mol % GaN, and 50 mol % GaN+50 mol % InN were formed furthermore on it in the thickness of 3 μm by the same MOCVD method as what was described in Example 19.

Also when the thin film of the above-mentioned constitution was formed on the substrate which consists of a sintered compact which is same as what was shown in Table 47 and comprises a beryllium oxide as the main ingredients, it was confirmed that it has the same effect as the thing in which the constitution is that the thin film formed beforehand is a 100 mol % AlN orientated polycrystal and that the thin film formed furthermore on it is a 100 mol % AlN or a 100 mol % GaN single crystal thin film.

For example, as for the crystallinity of the single crystal thin film formed furthermore on the formed beforehand thin film which comprises as the main ingredients at least one or more materials selected from a gallium nitride, an indium nitride, and an aluminum nitride and has various crystallized state, such as an amorphous state, a polycrystal, an orientated polycrystal, and a single crystal etc., it was confirmed that it is superior to the crystallinity of the single crystal thin film which comprises as the main ingredients at least one or more materials selected from a gallium nitride, an indium nitride, and an aluminum nitride and was directly formed on the same substrate which consists of a sintered compact which comprises a beryllium oxide as the main ingredients.

Thus, in this Example, when the substrate which consists of a sintered compact which comprises a beryllium oxide as the main ingredients is used, as for the crystallinity of the single crystal thin film which comprises as the main ingredients at least one or more materials selected from a gallium nitride, an indium nitride, and an aluminum nitride and is formed furthermore on it after beforehand forming the thin film which comprises as the main ingredients at least one or more materials selected from a gallium nitride, an indium nitride, and an aluminum nitride and has various crystallized state, such as an amorphous state, a polycrystal, an orientated polycrystal, and a single crystal etc., on this substrate, it was confirmed that the thing whose crystallinity is superior to the crystallinity of the single crystal thin film which was directly formed on this substrate and comprises as the main ingredients at least one or more materials selected from a gallium nitride, an indium nitride, and an aluminum nitride is obtained in all experiments.

In this Example, although the appearance of the thin film of a constitution of having indicated in Table 47 and all the thin films produced in addition to this was investigated, defects, such as a crack and a crevice, are not seen in all the thin films formed beforehand on the substrate and the thin films formed furthermore on it.

Although the exfoliation test by pressure sensitive adhesive tape was performed, in all thin films, exfoliation was not seen between the substrates which consists of a sintered compact which comprises a beryllium oxide as the main ingredients, and between thin films.

Although the thin film conductivity material of Ti/Pt/Au was formed on the thin film of the surface of a substrate, the metal lead was soldered and perpendicular tensile strength was investigated, it all is not less than 2 Kg/mm², so it has joined firmly between the sintered compact which comprises a beryllium oxide as the main ingredients and the thin film formed beforehand on this substrate, and between this thin film and the thin film formed furthermore on it.

### EXAMPLE 32

This Example shows the example which investigated the composition of this substrate and the influence which gives to the crystallinity of the thin film which is formed on this substrate and comprises as the main ingredients a gallium nitride, an indium nitride, and an aluminum nitride, when the sintered compact which comprises an aluminum oxide as the main ingredients is used as a substrate.

First, “A-31” grade by Nippon Light Metal Co., Ltd. is prepared as aluminum oxide (Al₂O₃) powder, what is 99.99% of purity by Kojundo Chemical Laboratory Co., Ltd. was prepared as magnesia (MgO) powder, what is 99.99% of purity by Kojundo Chemical Laboratory Co., Ltd. was prepared as calcium carbonate (CaCO₃) powder, the “SO-E2” grade of 99.9% of purity made by Admatechs Corp. was prepared as silica (SiO₂) powder.

It pulverized and mixed by a ball mill so that it may become predetermined composition about such powders by the same method as Example 1, then paraffine wax was added and the powder for molding was produced, it degreased after a uniaxial press molding to the powder compact of the same size as Example 1, it carried out the normal pressure sintering at 1550 degrees C. for 3 hours in air after that, the sintered compact which comprises an aluminum oxide as the main ingredients and contains a magnesium ingredient, a calcium ingredient, and a silicon ingredient in various rate was produced.

Each of these sintered compacts was made dense to not less than 98% of relative density.

Specular surface polish was carried out using the abradant which comprises as the main ingredients the colloidal alumina of particle diameter of 0.05 μm like Example 28, ultrasonic washing of the obtained sintered compact was carried out by methylene chloride and IPA, and the substrate was produced.

Average surface roughness Ra of the substrate which carried out specular surface polish was in the range of 6.7 nm-7.6 nm.

The optical transmissivity to the light with a wavelength 605 nm was measured by the same method as Example 2 using the substrate after polish.

Thus, the characteristic of the obtained substrate which consists of a sintered compact which comprises an aluminum oxide as the main ingredients is shown in Table 48.

Although the optical transmissivity of the sintered compact which comprises an aluminum oxide as the main ingredients and which does not contain anything other than the impurities substantially mixed in a raw material or at the time of sintered compact manufacture by being fired without adding a magnesium ingredient, a calcium ingredient, a silicon ingredient, and other ingredients was 18% to the light with a wavelength 605 nm, the tendency whose optical transmissivity also rises is shown according as the content of a magnesium ingredient, a calcium ingredient, and a silicon ingredient increases, it reached to 57% in what contains a magnesium ingredient 1.20 mol % by MgO conversion.

After that, the optical transmissivity lowers gradually according as the content of a magnesium ingredient, a calcium ingredient, and a silicon ingredient increases, the optical transmissivity to the light with a wavelength 605 nm becomes 22% in the sintered compact which comprises an aluminum oxide as the main ingredients and contains a calcium ingredient 20.0 mol % by CaO conversion, and a silicon ingredient 20.0 mol % by SiO₂ conversion simultaneously, the optical transmissivity became 6.4% in the sintered compact which comprises an aluminum oxide as the main ingredients and contains a magnesium ingredient 20.0 mol % by MgO conversion, and a silicon ingredient 30.0 mol % by SiO₂ conversion simultaneously.

In this Example, as for the optical transmissivity of the sintered compact which comprises an aluminum oxide as the main ingredients and which contains at least one or more of a magnesium ingredient, a calcium ingredient, and a silicon ingredient in the range of not more than 45.0 mol % in total by oxide conversion and contains furthermore at least one or more ingredients selected from rare earth element ingredients in the range of 0.0002 mol %-10.0 mol % in total by oxide conversion, it was confirmed that change of decreasing is hardly seen if it compared with the optical transmissivity of the sintered compact which comprises an aluminum oxide as the main ingredients and which does not contain a rare-earth-elements ingredient substantially but contains at least one or more of a magnesium ingredient, a calcium ingredient, and a silicon ingredient in the same quantity as the above.

That is, although the optical transmissivity of the sintered compact which comprises an aluminum oxide as the main ingredients and contains a calcium ingredient 0.050 mol % by CaO conversion is 36% to the light with a wavelength 605 nm, the optical transmissivity of the sintered compact which comprises an aluminum oxide as the main ingredients and contains a calcium ingredient 0.050 mol % by CaO conversion, and a yttrium ingredient 0.04 mol % by Y₂O₃ conversion simultaneously was 37%, it hardly changes, it was confirmed that influence by containing a rare earth element ingredient in the sintered compact which comprises an aluminum oxide as the main ingredients besides a magnesium ingredient, a calcium ingredient, and a silicon ingredient is seldom seen.

Furthermore, although the optical transmissivity of the sintered compact which comprises an aluminum oxide as the main ingredients and contains a magnesium ingredient 1.20 mol % by MgO conversion is 57% to the light with a wavelength 605 nm, it had comparatively high optical transmissivity, the optical transmissivity of the sintered compact which comprises an aluminum oxide as the main ingredients and contains a magnesium ingredient 1.20 mol % by MgO conversion, and a yttrium ingredient 0.04 mol % by Y₂O₃ conversion simultaneously was also 59%, the optical transmissivity of the sintered compact which comprises an aluminum oxide as the main ingredients and contains a magnesium ingredient 1.20 mol % by MgO conversion, and a holmium ingredient 0.04 mol % by Ho₂O₃ conversion simultaneously was also 56%, and the optical transmissivity of the sintered compact which comprises an aluminum oxide as the main ingredients and contains a magnesium ingredient 1.20 mol % by MgO conversion, and a ytterbium ingredient 0.04 mol % by Yb₂O₃ conversion simultaneously was also 58%, the optical transmissivity was comparatively high, the phenomenon in which optical transmissivity fell greatly and had bad influence by containing rare earth element ingredients including yttrium was not seen.

In Table 48, the optical transmissivity of the sintered compact which comprises an aluminum oxide as the main ingredients and which contains a calcium ingredient 0.050 mol % by CaO conversion and further contains simultaneously a yttrium ingredient 8.0 mol % by Y₂O₃ conversion was 36% to the light with a wavelength 605 nm, the optical transmissivity of the sintered compact which comprises an aluminum oxide as the main ingredients and which contains a calcium ingredient 0.05 mol % by CaO conversion and contains further a yttrium ingredient 12.0 mol % by Y₂O₃ conversion simultaneously was 27% to the light with a wavelength 605 nm.

Thus, in this Example, as for the sintered compact which comprises an aluminum oxide as the main ingredients and which contains at least one or more of a magnesium ingredient, a calcium ingredient, and a silicon ingredient in the range of not more than 45.0 mol % in total by oxide conversion and contains furthermore at least one or more ingredients selected from rare earth element ingredients in the range of 0.0002 mol %-10.0 mol % in total by oxide conversion, it was confirmed that the thing which is the optical transmissivity not less than 30% to the light with 605 nm wavelength can produce.

Furthermore, in this Example, as for the sintered compact which comprises an aluminum oxide as the main ingredients and which contains at least two or more of a magnesium ingredient, a calcium ingredient, and a silicon ingredient and contains simultaneously at least one or more ingredients selected from a rare earth element ingredient, it was confirmed that the thing which has higher optical transmissivity can produce.

It was also confirmed that the sintered compact which has the optical transmissivity of a maximum of not less than 80% and comprises an aluminum oxide as the main ingredients can manufacture.

That is, as shown in Table 48, as for the sintered compact which comprises an aluminum oxide as the main ingredients and which contains a magnesium ingredient 0.60 mol % by MgO conversion, a calcium ingredient 0.80 mol % by CaO conversion, and a silicon ingredient 0.80 mol % by SiO₂ conversion simultaneously and contains further a yttrium ingredient 0.0080 mol % by Y₂O₃ conversion, and a dysprosium ingredient 0.040 mol % by Dy₂O₃ conversion, respectively, the optical transmissivity to the light with a wavelength 605 nm increased to 57% and 78%, respectively.

As for the sintered compact which comprises an aluminum oxide as the main ingredients and which contains a magnesium ingredient 0.60 mol % by MgO conversion, and a silicon ingredient 0.20 mol % by SiO₂ conversion simultaneously and contains further a yttrium ingredient 0.040 mol % by Y₂O₃ conversion, the optical transmissivity to the light with a wavelength 605 nm was 69%.

Furthermore, the optical transmissivity of the sintered compact which comprises an aluminum oxide as the main ingredients and which contains a magnesium ingredient 1.0 mol % by MgO conversion, and a calcium ingredient 0.20 mol % by CaO conversion simultaneously and contains further a rare earth element ingredient, such as yttrium, 0.040 mol % by oxide conversion was as high as 81%-82% to the light with a wavelength 605 nm.

That is, as for the sintered compact which comprises an aluminum oxide as the main ingredients, and which contains a yttrium ingredient 0.040 mol % by Y₂O₃ conversion as a rare earth element ingredient simultaneously with the magnesium ingredient and the calcium ingredient of the above-mentioned amount, the optical transmissivity to the light with a wavelength 605 nm is 82%, in the sintered compact which comprises an aluminum oxide as the main ingredients and contains simultaneously an erbium ingredient 0.04 mol % by Er₂O₃ conversion, optical transmissivity was 81%.

Next, the thin film was formed by the same method as what was shown in Example 27 to the prepared above-mentioned substrate.

That is, choosing a part of prepared substrate, the thin film of a 100 mol % AlN was formed beforehand on it in the thickness of 3 μm according to the same conditions as the sputtering method which was performed in experiment No. 708 of Example 25.

Next, using the above mentioned substrate which consists of a sintered compact which comprises an aluminum oxide as the main ingredients and which formed beforehand an AlN thin film and the substrate which consists of a sintered compact which comprises an aluminum oxide as the main ingredients and which was left without forming an AlN thin film, the thin films of each composition of the same 100 mol % AlN and 100 mol % GaN as what was described in Example 19 were formed furthermore on it in the thickness of 3 μm by the MOCVD method.

They were the same conditions as Example 1 and Example 2 like a publication in Example 19 as conditions of MOCVD.

Thus, the characteristic of the thin film produced like that was shown in Table 48.

In this Example, in the 100 mol % AlN thin film formed beforehand on each above-mentioned substrate, only the diffraction line from the lattice plane of a Miller Index (002) had appeared, it was clearly the orientated polycrystal formed in the direction where C axis is perpendicular to the substrate surface.

When the substrate which consists of a sintered compact which comprises an aluminum oxide as the main ingredients and which does not contain a magnesium ingredient, a calcium ingredient, and a silicon ingredient substantially was used as shown in Table 48, if the crystallinity of the AlN orientated polycrystalline thin film formed beforehand on each above-mentioned substrate was seen, the half width of the rocking curve of the X ray diffraction line from the lattice plane of the Miller Index (002) of this orientated polycrystalline thin film was 9720 seconds.

The crystallinity of this orientated polycrystalline thin film showed the tendency to improve according as the magnesium ingredient, the calcium ingredient, and the silicon ingredient increase. That is, when the substrate which consists of a sintered compact which comprises an aluminum oxide as the main ingredients and contains a calcium ingredient 0.0005 mol % by CaO conversion was used, though it was 9240 seconds, when the substrate which consists of a sintered compact which comprises an aluminum oxide as the main ingredients and contains a silicon ingredient 0.0020 mol % by SiO₂ conversion was used, it was 8660 seconds, when the substrate which consists of a sintered compact which comprises an aluminum oxide as the main ingredients and contains a magnesium ingredient 0.010 mol % by MgO conversion was used, that was 7810 seconds, it fell to not more than 8000 seconds.

After that, the crystallinity of this AlN orientated polycrystalline thin film showed the tendency to improve a little according as the content of a magnesium ingredient, a calcium ingredient, and a silicon ingredient increases.

When the substrate which consists of a sintered compact which comprises an aluminum oxide as the main ingredients and contains a magnesium ingredient 1.0 mol % by MgO conversion, and a calcium ingredient 0.20 mol % by CaO conversion simultaneously was used, that was 7240 seconds, and it improved most.

After that, the crystallinity of this AlN orientated polycrystalline thin film showed the tendency to lower a little according as the content of a magnesium ingredient, a calcium ingredient, and a silicon ingredient increases.

In the case of an AlN orientated polycrystalline thin film formed on the substrate which consists of a sintered compact which comprises an aluminum oxide as the main ingredients and contains simultaneously a calcium ingredient of 20.0 mol % by CaO conversion and a silicon ingredient of 20.0 mol % by Sio₂ conversion, that was 7830 seconds.

However, in the case of an AlN orientated polycrystalline thin film formed on the substrate which consists of a sintered compact which comprises an aluminum oxide as the main ingredients and contains simultaneously a magnesium ingredient of 20.0 mol % by MgO conversion and a silicon ingredient of 30.0 mol % by SiO₂ conversion, that was 9370 seconds, the crystallinity fell.

When the crystallinity of the AlN orientated polycrystalline thin film formed on the substrate which consists of a sintered compact which comprises an aluminum oxide as the main ingredients and which contains at least one or more of a magnesium ingredient, a calcium ingredient, and a silicon ingredient a total of not more than 45.0 mol % by oxide conversion and contains further at least one or more ingredients selected from rare earth element ingredients was compared with the crystallinity of the AlN orientated polycrystalline thin film formed on the substrate which consists of a sintered compact which comprises an aluminum oxide as the main ingredients and which does not contain a rare-earth-elements ingredient substantially but contains at least one or more ingredients selected from a magnesium ingredient, a calcium ingredient, and a silicon ingredient in the same quantity as the above, the crystallinity seldom changes, it was confirmed that influence by containing a rare earth element ingredient in the sintered compact which comprises an aluminum oxide as the main ingredients besides a magnesium ingredient, a calcium ingredient, and a silicon ingredient is seldom seen.

In this Example, the half width of the rocking curve of the X ray diffraction line from the lattice plane of the Miller Index (002) of this orientated polycrystalline thin film formed on the substrate which consists of a sintered compact which comprises an aluminum oxide as the main ingredients and which contains at least one or more of these magnesium ingredient, calcium ingredient, and silicon ingredient and contains furthermore rare earth element ingredients is a range of 7070 seconds-7830 seconds, it was not more than 8000 seconds altogether.

Next, as for the thin film which consists of each composition of 100 mol % AlN and 100 mol % GaN and which was formed by the above-mentioned MOCVD method using the substrate which consists of a sintered compact which comprises an aluminum oxide as the main ingredients and which was left without forming beforehand the above thin film, the crystallinity was investigated by X ray diffraction.

Consequently, it was confirmed that all the produced thin films are the single crystals formed in the direction where C axis is perpendicular to the substrate surface.

If the crystallinity is seen, as for the half width of the rocking curve of the X ray diffraction line from the lattice plane of the Miller Index (002) of the 100 mol % AlN single crystal thin film forming directly on the substrate which consists of a sintered compact which comprises an aluminum oxide as the main ingredients and does not contain anything other than the impurities substantially mixed in a raw material or at the time of sintered compact manufacture by being fired without adding a magnesium ingredient, a calcium ingredient, a silicon ingredient, and other ingredients as shown in Table 48, it was 274 seconds.

On the other hand, in the case of the 100 mol % AlN single crystal thin film directly formed on the substrate which consists of a sintered compact which comprises an aluminum oxide as the main ingredients and contains a calcium ingredient 0.0005 mol % by CaO conversion, it became small with 215 seconds, and its crystallinity improved.

Furthermore, in the case of the 100 mol % AlN single crystal thin film directly formed on the substrate which consists of a sintered compact which comprises an aluminum oxide as the main ingredients and contains a silicon ingredient 0.0020 mol % by SiO₂ conversion, it was 187 seconds, in the case of the 100 mol % AlN single crystal thin film directly formed on the substrate which consists of a sintered compact which comprises an aluminum oxide as the main ingredients and contains a magnesium ingredient 0.010 mol % by MgO conversion, that was 156 seconds, it has been not more than 200 seconds, respectively, and crystallinity improved.

In the case of the 100 mol % AlN single crystal thin film directly formed on the substrate which consists of a sintered compact which comprises an aluminum oxide as the main ingredients and contains a calcium ingredient 0.050 mol % by CaO conversion, that was 140 seconds, it has been not more than 150 seconds, the crystallinity improved more.

In the case of the 100 mol % AlN single crystal thin film directly formed on the substrate which consists of a sintered compact which comprises an aluminum oxide as the main ingredients and which contains a magnesium ingredient 0.12 mol % by MgO conversion, it was 119 seconds, in the case of the 100 mol % AlN single crystal thin film directly formed on the substrate which consists of a sintered compact which comprises an aluminum oxide as the main ingredients and which contains a magnesium ingredient 0.60 mol % by MgO conversion, and a silicon ingredient 0.20 mol % by SiO₂ conversion, it was 116 seconds, it had been not more than 130 seconds, respectively, and crystallinity improved further.

After that, the half width of the rocking curve of the X ray diffraction line from the lattice plane of the Miller Index (002) of the single crystal thin film directly formed on the substrate which consists of a sintered compact which comprises an aluminum oxide as the main ingredients became small as the content of a magnesium ingredient, a calcium ingredient, and a silicon ingredient increased.

That is, in the case of the 100 mol % AlN single crystal thin film directly formed on the substrate which consists of a sintered compact which comprises an aluminum oxide as the main ingredients and contains a magnesium ingredient 1.20 mol % by MgO conversion, it was 114 seconds, in the case of the 100 mol % AlN single crystal thin film directly formed on the substrate which consists of a sintered compact which comprises an aluminum oxide as the main ingredients and contains a magnesium ingredient 1.00 mol % by MgO conversion, and a calcium ingredient 0.20 mol % by CaO conversion simultaneously, it was 113 seconds, it became the smallest in the single crystal thin film directly formed on the substrate in this Example, and crystallinity was most excellent.

After that, the half width of the rocking curve of the X ray diffraction line from the lattice plane of the Miller Index (002) of the single crystal thin film directly formed on the substrate which consists of a sintered compact which comprises an aluminum oxide as the main ingredients becomes large as the content of a magnesium ingredient, a calcium ingredient, and a silicon ingredient increases, in the case of the 100 mol % AlN single crystal thin film directly formed on the substrate which consists of a sintered compact which comprises an aluminum oxide as the main ingredients and contains simultaneously a calcium ingredient of 20.0 mol % by CaO conversion and a silicon ingredient of 20.0 mol % by SiO₂ conversion, it has been 141 seconds.

In the case of the 100 mol % AlN single crystal thin film directly formed on the substrate which consists of a sintered compact which comprises an aluminum oxide as the main ingredients and which contains a magnesium ingredient 20.0 mol % by MgO conversion, and a silicon ingredient 30.0 mol % by SiO₂ conversion simultaneously, it had been 226 seconds, it became larger than 200 seconds.

On the other hand, in Example, as shown in Table 48, as for the substrate which consists of a sintered compact which comprises an aluminum oxide as the main ingredients and contains at least one or more of a magnesium, a calcium, and a silicon ingredient, even if ingredients other than a magnesium, a calcium, and a silicon ingredient, such as a rare earth element, were contained in this sintered compact, it was confirmed that there is little change of lowering greatly the crystallinity of a single crystal thin film which comprises as the main ingredients at least one or more materials selected from a gallium nitride, an indium nitride, and an aluminum nitride and which is directly formed on this substrate.

If saying in other words, in the case of the substrate which consists of a sintered compact which comprises an aluminum oxide as the main ingredients and contains at least one or more of a magnesium, a calcium, and a silicon ingredient, even if ingredients other than a magnesium, a calcium, and a silicon ingredient, such as a rare earth element, were contained in this sintered compact, it was confirmed that the crystallinity of the single crystal thin film directly formed on this substrate is what cannot be influenced easily by these ingredients.

Concretely saying, the half width of the rocking curve of the X ray diffraction line from the lattice plane of the Miller Index (002) of the 100 mol % AlN single crystal thin film directly formed on the substrate which consists of a sintered compact which comprises an aluminum oxide as the main ingredients and which contains a calcium ingredient 0.050 mol % by CaO conversion and contains simultaneously a yttrium ingredient 0.040 mol %, 8.00 mol %, and 12.0 mol % by Y₂O₃ conversion, respectively, is 137 seconds, 127seconds, and 134 seconds, respectively, as for the crystallinity, the change tendency of lowering greatly from 140 seconds of the 100 mol % AlN single crystal thin film directly formed on the substrate which consists of a sintered compact which comprises an aluminum oxide as the main ingredients and which contains a calcium ingredient 0.05 mol % by CaO conversion and does not contain a yttrium ingredient substantially was not shown.

The half width of the rocking curve of the X ray diffraction line from the lattice plane of the Miller Index (002) of the 100 mol % AlN single crystal thin film directly formed on the substrate which consists of a sintered compact which comprises an aluminum oxide as the main ingredients and which contains a magnesium ingredient 1.20 mol % by MgO conversion and contains simultaneously a yttrium ingredient 0.040 mol % by Y₂O₃ conversion and the substrate which consists of a sintered compact which comprises an aluminum oxide as the main ingredients and which contains a magnesium ingredient 1.20 mol % by MgO conversion and contains simultaneously a ytterbium ingredient 0.040 mol % by Yb₂O₃ conversion is 112 seconds and 115 seconds, respectively, as for the crystallinity, the change tendency of lowering greatly if it is compared with 114 seconds of the 100 mol % AlN single crystal thin film directly formed on the substrate which consists of a sintered compact which comprises an aluminum oxide as the main ingredients and which contains only a magnesium ingredient 1.20 mol % by MgO conversion and does not contain a yttrium ingredient substantially was not shown.

The half width of the rocking curve of the X ray diffraction line from the lattice plane of the Miller Index (002) of the 100 mol % AlN single crystal thin film directly formed on the substrate which consists of a sintered compact which comprises an aluminum oxide as the main ingredients and which contains a magnesium ingredient 1.20 mol % by MgO conversion and contains simultaneously a holmium ingredient 0.040 mol % by Ho₂O₃ conversion is 115 seconds, as for the crystallinity, the change tendency of lowering greatly was not shown if it is compared with 114 seconds of the 100 mol % AlN single crystal thin film directly formed on the substrate which consists of a sintered compact which comprises an aluminum oxide as the main ingredients and which contains only a magnesium ingredient 1.20 mol % by MgO conversion and does not contain rare earth element ingredients, such as yttrium, substantially.

The half width of the rocking curve of the X ray diffraction line from the lattice plane of the Miller Index (002) of the 100 mol % AlN single crystal thin film directly formed on the substrate which consists of a sintered compact which comprises an aluminum oxide as the main ingredients and which contains simultaneously a silicon ingredient 0.0020 mol % by SiO₂ conversion and contains a yttrium ingredient 0.0005 mol % by Y₂O₃ conversion is 161 seconds, as for the crystallinity, the change tendency of lowering greatly from 187 seconds of the 100 mol % AlN single crystal thin film directly formed on the substrate which consists of a sintered compact which comprises an aluminum oxide as the main ingredients and which contains a silicon ingredient 0.0020 mol % by SiO₂ conversion and does not contain a yttrium ingredient substantially was not shown.

The half width of the rocking curve of the X ray diffraction line from the lattice plane of the Miller Index (002) of the 100 mol % AlN single crystal thin film directly formed on the substrate which consists of a sintered compact which comprises an aluminum oxide as the main ingredients, and which contains simultaneously a magnesium ingredient 0.60 mol % by MgO conversion, a calcium ingredient 0.80 mol % by CaO conversion, and a silicon ingredient 0.80 mol % by SiO₂ conversion and further contains a yttrium ingredient 0.0080 mol % by Y₂O₃ conversion and a dysprosium ingredient 0.040 mol % by Dy₂O₃ conversion is 111 seconds and 113 seconds, respectively, as for the crystallinity, the change tendency of lowering greatly from 120 seconds of the 100 mol % AlN single crystal thin film directly formed on the substrate which consists of a sintered compact which comprises an aluminum oxide as the main ingredients, and which contains simultaneously a magnesium ingredient 0.60 mol % by MgO conversion, a calcium ingredient 0.80 mol % by CaO conversion, and a silicon ingredient 0.80 mol % by SiO₂ conversion and does not contain a yttrium ingredient substantially was not shown.

The half width of the rocking curve of the X ray diffraction line from the lattice plane of the Miller Index (002) of the 100 mol % AlN single crystal thin film directly formed on the substrate which consists of a sintered compact which comprises an aluminum oxide as the main ingredients, and which contains simultaneously a magnesium ingredient 0.60 mol % by MgO conversion and a silicon ingredient 0.20 mol % by SiO₂ conversion and further contains a yttrium ingredient 0.040 mol % by Y₂O₃ conversion is 112 seconds, as for the crystallinity, the change tendency of lowering greatly from 116 seconds of the 100 mol % AlN single crystal thin film directly formed on the substrate which consists of a sintered compact which comprises an aluminum oxide as the main ingredients, and which contains simultaneously a magnesium ingredient 0.60 mol % by MgO conversion and a silicon ingredient 0.20 mol % by SiO₂ conversion and does not contain a yttrium ingredient substantially was not shown.

The half width of the rocking curve of the X ray diffraction line from the lattice plane of the Miller Index (002) of the 100 mol % AlN single crystal thin film directly formed on the substrate which consists of a sintered compact which comprises an aluminum oxide as the main ingredients and which contains a magnesium ingredient 1.00 mol % by MgO conversion, and a calcium ingredient 0.20 mol % by CaO conversion simultaneously and contains further a yttrium ingredient 0.040 mol % by Y₂O₃ conversion is 107 seconds, as for the crystallinity, the change tendency of lowering greatly from 113 seconds of the 100 mol % AlN single crystal thin film directly formed on the substrate which consists of a sintered compact which comprises an aluminum oxide as the main ingredients and which contains a magnesium ingredient 1.00 mol % by MgO conversion, and a calcium ingredient 0.20 mol % by CaO conversion simultaneously and does not contain a yttrium ingredient substantially was not shown.

The half width of the rocking curve of the X ray diffraction line from the lattice plane of the Miller Index (002) of the 100 mol % AlN single crystal thin film directly formed on the substrate which consists of a sintered compact which comprises an aluminum oxide as the main ingredients and which contains simultaneously a magnesium ingredient 1.00 mol % by MgO conversion and a calcium ingredient 0.20 mol % by CaO conversion and further contains an erbium ingredient 0.040 mol % by Er₂O₃ conversion is 109 seconds, as for the crystallinity, the change tendency of lowering greatly from 113 seconds of the 100 mol % AlN single crystal thin film directly formed on the substrate which consists of a sintered compact which comprises an aluminum oxide as the main ingredients and which contains simultaneously a magnesium ingredient 1.00 mol % by MgO conversion and a calcium ingredient 0.20 mol % by CaO conversion and does not contain rare earth element ingredients, such as yttrium, substantially was not shown.

Thus, as for the substrate which consists of a sintered compact which comprises an aluminum oxide as the main ingredients and contains at least one or more materials selected from a magnesium ingredient, a calcium ingredient, and a silicon ingredient, even if these substrates were what consists of a sintered compact which comprises an aluminum oxide as the main ingredients and contains simultaneously rare earth element ingredients, such as yttrium, other than a magnesium ingredient, a calcium ingredient, and a silicon ingredient, the crystallinity of the single crystal thin film which comprises a gallium nitride and an aluminum nitride as the main ingredients and is directly formed on this substrate changes little, having the tendency to be hard to be influenced by the existence of rare earth element ingredients, such as a yttrium ingredient, was confirmed.

As mentioned above, the half width of the rocking curve of the X ray diffraction line from the lattice plane of the Miller Index (002) of the 100 mol % AlN single crystal thin film and the 100 mol % GaN single crystal thin film which were directly formed on the substrate which consists of a sintered compact which comprises an aluminum oxide as the main ingredients and which has various compositions was not more than 300 seconds altogether, it was excellent in crystallinity.

In this Example, when the substrate which consists of a sintered compact which comprises an aluminum oxide as the main ingredients and which has such characteristic and has the above various compositions is used, if the orientated polycrystalline thin film which comprises an aluminum nitride as the main ingredients is formed beforehand on this substrate, and the single crystal thin film which comprises as the main ingredients at least one or more materials selected from a gallium nitride and an aluminum nitride is formed furthermore on it, as for the crystallinity of this single crystal thin film, it was confirmed that the thing which is more excellent in crystallinity than the crystallinity of the single crystal thin film which is directly formed on this substrate and comprises as the main ingredients at least one or more materials selected from a gallium nitride and an aluminum nitride is obtained.

That is, by using the sintered compact which comprises an aluminum oxide as the main ingredients and which has various compositions is used as a substrate, it does not necessarily restrict that half width of the rocking curve of the X ray diffraction line from the lattice plane of a Miller Index (002) of the single crystal thin film which comprises as the main ingredients at least one or more materials selected from a gallium nitride and an aluminum nitride which are directly formed on this substrate becomes not more than 200 seconds.

On the other hand, even if the sintered compact which comprises an aluminum oxide as the main ingredients and has such various compositions is used as a substrate, if the orientated polycrystalline thin film which comprises an aluminum nitride as the main ingredients is formed beforehand on this substrate, and the single crystal thin film which comprises as the main ingredients at least one or more materials selected from a gallium nitride and an aluminum nitride is formed furthermore on it, it was confirmed that the thing which is not more than 200 seconds can be formed as half width of the rocking curve of the X ray diffraction line from the lattice plane of the Miller Index (002) of this single crystal thin film.

When the single crystal thin film which comprises as the main ingredients at least one or more materials selected from a gallium nitride and an aluminum nitride is formed using the substrate which consists of a sintered compact which comprises an aluminum oxide as the main ingredients and has the same composition, if the orientated polycrystalline thin film which comprises an aluminum nitride as the main ingredients is formed beforehand on this substrate, and the single crystal thin film which comprises as the main ingredients at least one or more materials selected from a gallium nitride and an aluminum nitride is formed furthermore on it, as for the crystallinity of this single crystal thin film, it was confirmed that the thing which is more excellent in crystallinity than the crystallinity of the single crystal thin film which is directly formed on this substrate and comprises as the main ingredients at least one or more materials selected from a gallium nitride and an aluminum nitride is obtained.

That is, by using as a substrate the sintered compact which comprises an aluminum oxide as the main ingredients and contains at least one or more of a magnesium ingredient, a calcium ingredient, and a silicon ingredient in the range of 0.001 mol %-45.0 mol % in total by oxide conversion, if the orientated polycrystalline thin film which comprises an aluminum nitride as the main ingredients is formed beforehand on it and the single crystal thin film which comprises as the main ingredients at least one or more materials selected from a gallium nitride and an aluminum nitride are formed furthermore on it, the half width of the rocking curve of the X ray diffraction line from the lattice plane of the Miller Index (002) of this single crystal thin film tends to become the thing excellent in crystallinity not more than 130 seconds, by using as a substrate the sintered compact which comprises an aluminum oxide as the main ingredients and contains at least one or more of a magnesium ingredient, a calcium ingredient, and a silicon ingredient in the range of 0.005 mol %-45.0 mol % in total by oxide conversion, if the orientated polycrystalline thin film which comprises an aluminum nitride as the main ingredients is formed beforehand on it and the single crystal thin film which comprises as the main ingredients at least one or more materials selected from a gallium nitride and an aluminum nitride are formed furthermore on it, it was confirmed that the thing which is excellent in crystallinity not more than 100 seconds as half width of the rocking curve of the X ray diffraction line from the lattice plane of the Miller Index (002) of this single crystal thin film can form comparatively easily.

Even if it is the substrate which consists of a sintered compact which comprises an aluminum oxide as the main ingredients and contains the above amount of a magnesium ingredient, a calcium ingredient, and a silicon ingredient and contains simultaneously ingredients, such as a yttrium ingredient, a dysprosium ingredient, a holmium ingredient, an erbium ingredient, and a ytterbium ingredient, etc., besides these, as for the crystallinity of the single crystal thin film formed on this substrate, it was confirmed that it is hard to receive change of reducing greatly if it is compared with the crystallinity of a single crystal thin film formed on the substrate which consists of a sintered compact which comprises an aluminum oxide as the main ingredients and which contains the above-mentioned magnesium ingredient, a calcium ingredient, and a silicon ingredient and does not contain substantially ingredients, such as a yttrium ingredient, a dysprosium ingredient, a holmium ingredient, an erbium ingredient, and a ytterbium ingredient, etc. other than these.

That is, if it is the substrate which consists of a sintered compact which comprises an aluminum oxide as the main ingredients and contains the above amount of at least one or more ingredients selected from a magnesium ingredient, a calcium ingredient, and a silicon ingredient, even if ingredients other than a magnesium ingredient, a calcium ingredient, and a silicon ingredient, such as a yttrium ingredient, a dysprosium ingredient, a holmium ingredient, an erbium ingredient, and a ytterbium ingredient, were contained, it was confirmed that the crystallinity of the formed single crystal thin film which comprises as the main ingredients at least one or more materials selected from a gallium nitride and an aluminum nitride cannot be influenced easily by these ingredients. More concretely saying, as shown in Table 48, while the half width of the 100 mol % AlN single crystal thin film directly formed on the substrate which consists of a sintered compact which comprises an aluminum oxide as the main ingredients and does not contain anything other than the impurities substantially mixed in a raw material or at the time of sintered compact manufacture by being fired without adding a magnesium ingredient, a calcium ingredient, a silicon ingredient, and other ingredients was 274 seconds, the half width of the rocking curve of the X ray diffraction line from the lattice plane of the Miller Index (002) of the 100 mol % AlN single crystal thin film which was formed furthermore on the 100 mol % AlN orientated polycrystalline thin film which was formed beforehand on the substrate which consists of a same sintered compact which comprises an aluminum oxide as the main ingredients is 142 seconds, the crystallinity improved.

While the half width of the rocking curve of the X ray diffraction line from the lattice plane of the Miller Index (002) of the 100 mol % AlN single crystal thin film directly formed on this substrate is 215 seconds when the substrate which consists of a sintered compact which comprises an aluminum oxide as the main ingredients and contains a calcium ingredient 0.0005 mol % by CaO conversion is used, the half width of the rocking curve of the X ray diffraction line from the lattice plane of the Miller Index (002) of the 100 mol % AlN single crystal thin film which was formed furthermore on the 100 mol % AlN orientated polycrystalline thin film which was formed beforehand on the substrate which consists of a same sintered compact which comprises an aluminum oxide as the main ingredients and contains a calcium ingredient is 133 seconds, the crystallinity improved.

Furthermore, while the half width of the rocking curve of the X ray diffraction line from the lattice plane of the Miller Index (002) of the 100 mol % AlN single crystal thin film directly formed on this substrate is 187 seconds when the substrate which consists of a sintered compact which comprises an aluminum oxide as the main ingredients and contains a silicon ingredient 0.0020 mol % by SiO₂ conversion is used, the half width of the rocking curve of the X ray diffraction line from the lattice plane of the Miller Index (002) of the 100 mol % AlN single crystal thin film which was formed furthermore on the 100 mol % AlN orientated polycrystalline thin film which was formed beforehand on the substrate which consists of a same sintered compact which comprises an aluminum oxide as the main ingredients and contains a silicon ingredient is 122 seconds, the crystallinity improved.

While the half width of the rocking curve of the X ray diffraction line from the lattice plane of the Miller Index (002) of the 100 mol % AlN single crystal thin film directly formed on this substrate is 156 seconds when the substrate which consists of a sintered compact which comprises an aluminum oxide as the main ingredients and contains a magnesium ingredient 0.010 mol % by MgO conversion is used, the half width of the rocking curve of the X ray diffraction line from the lattice plane of the Miller Index (002) of the 100 mol % AlN single crystal thin film which was formed furthermore on the 100 mol % AlN orientated polycrystalline thin film which was formed beforehand on the substrate which consists of a same sintered compact which comprises an aluminum oxide as the main ingredients and contains a magnesium ingredient is 96 seconds, it became not more than 100 seconds.

Following, when the substrate which consists of a sintered compact which comprises an aluminum oxide as the main ingredients and contains at least one or more ingredients selected from a magnesium ingredient, a calcium ingredient, and a silicon ingredient in the range of 0.001 mol %-45.0 mol % in total by oxide conversion is used, if the single crystal thin film which comprises as the main ingredients at least one or more materials selected from a gallium nitride and an aluminum nitride is formed furthermore on it after beforehand forming the orientated polycrystalline thin film which comprises an aluminum nitride as the main ingredients, the thing whose crystallinity is superior to the crystallinity of the single crystal thin film which was directly formed on this substrate and comprises as the main ingredients at least one or more materials selected from a gallium nitride, an indium nitride, and an aluminum nitride is obtained, it was confirmed that the half width of the rocking curve of the X ray diffraction line from the lattice plane of the Miller Index (002) of this single crystal thin film is in the range of 90 seconds-97 seconds, and it is not more than 100 seconds altogether.

While the half width of the rocking curve of the X ray diffraction line from the lattice plane of the Miller Index (002) of this single crystal thin film is 226 seconds in the case of the 100 mol % AlN single crystal thin film directly formed on the substrate which consists of a sintered compact which comprises an aluminum oxide as the main ingredients and contains a magnesium ingredient 20.0 mol % by MgO conversion, and a silicon ingredient 30.0 mol % by SiO₂ conversion simultaneously, the crystallinity has improved to 147 seconds in the case of 100 mol % AlN single crystal thin film which was formed furthermore on the 100 mol % AlN orientated polycrystalline thin film which was formed beforehand on the same substrate.

As shown in Table 48, even when the substrate which consists of a sintered compact which comprises an aluminum oxide as the main ingredients and which contains at least one or more ingredients selected from magnesium, calcium, and silicon and further contains at least one or more ingredients selected from rare earth element ingredients was used, if the 100 mol % AlN orientated polycrystalline thin film or the 100 mol % GaN orientated polycrystalline thin film is formed beforehand on the substrate which consists of a same sintered compact which comprises an aluminum oxide as the main ingredients and which contains at least one or more ingredients selected from magnesium, calcium, and silicon and further contains at least one or more ingredients selected from rare earth element ingredients, and if the 100 mol % AlN single crystal thin film or the 100 mol % GaN single crystal thin film is formed furthermore on it, it was confirmed that the crystallinity of this single crystal thin film improves than the crystallinity of the 100 mol % AlN single crystal thin film or the 100 mol % GaN single crystal thin film, which were directly formed on this substrate.

For example, as shown in Table 48, when what formed beforehand the 100 mol % AlN orientated polycrystalline thin film on the substrate which consists of a sintered compact which comprises an aluminum oxide as the main ingredients and which contains a silicon ingredient 0.0020 mol % by SiO₂ conversion and contains further a yttrium ingredient 0.0005 mol % by Y₂O₃ conversion besides it was used, the half width of the rocking curve of the X ray diffraction line from the lattice plane of the Miller Index (002) of the single crystal thin film formed on it improved with 104 seconds.

Furthermore, when what formed beforehand the 100 mol % AlN orientated polycrystalline thin film on the substrate which consists of a sintered compact which comprises an aluminum oxide as the main ingredients and which contains a calcium ingredient 0.050 mol % by CaO conversion and contains further a yttrium ingredient 0.040 mol % by Y₂O₃ conversion besides it was used, the half width of the rocking curve of the X ray diffraction line from the lattice plane of the Miller Index (002) of the single crystal thin film formed on it was 95 seconds, it improved at not more than 100 seconds.

When what formed beforehand the 100 mol % GaN orientated polycrystalline thin film on the substrate which consists of a sintered compact which comprises an aluminum oxide as the main ingredients and which contains a magnesium ingredient 1.20 mol % by MgO conversion and contains further a yttrium ingredient 0.040 mol % by Y₂O₃ conversion, a ytterbium ingredient 0.040 mol % by Yb203 conversion, respectively, besides it was used, the half width of the rocking curve of the X ray diffraction line from the lattice plane of the Miller Index (002) of the single crystal thin film formed on it was 89 seconds and 90 seconds, respectively, it was not more than 100 seconds altogether.

As shown in Table 48, even when the substrate which consists of a sintered compact which comprises an aluminum oxide as the main ingredients and which contains at least two or more ingredients selected from magnesium, calcium, and silicon and further contains at least one or more ingredients selected from rare earth element ingredients was used, if the 100 mol % AlN orientated polycrystalline thin film or the 100 mol % GaN orientated polycrystalline thin film is formed beforehand on the substrate which consists of a same sintered compact which comprises an aluminum oxide as the main ingredients and which contains at least two or more ingredients selected from magnesium, calcium, and silicon and further contains at least one or more ingredients selected from rare earth element ingredients, and if the 100 mol % AlN single crystal thin film or the 100 mol % GaN single crystal thin film is formed furthermore on it, it was confirmed that the crystallinity of this single crystal thin film improves than the crystallinity of the 100 mol % AlN single crystal thin film or the 100 mol % GaN single crystal thin film, which were directly formed on this substrate.

For example, while the half width of the rocking curve of the X ray diffraction line from the lattice plane of the Miller Index (002) of the 100 mol % AlN single crystal thin film directly formed on this substrate is 111 seconds and 113 seconds, respectively, when the substrate which consists of a sintered compact which comprises an aluminum oxide as the main ingredients and which contains a magnesium ingredient 0.60 mol % by MgO conversion, and a calcium ingredient 0.80 mol % by CaO conversion, and a silicon ingredient 0.80 mol % by SiO₂ conversion and contains further a yttrium ingredient 0.0080 mol % by Y₂O₃ conversion, and a dysprosium ingredient 0.040 mol % by Dy₂O₃ conversion besides these was used, the half width of the rocking curve of the X ray diffraction line from the lattice plane of the Miller Index (002) of the 100 mol % AlN single crystal thin film which was formed furthermore on the 100 mol % AlN orientated polycrystalline thin film which was formed beforehand on the substrate which consists of a sintered compact which comprises an aluminum oxide as the main ingredients and contains a same ingredient is 92 seconds and 90 seconds, respectively, the crystallinity improved.

While the half width of the rocking curve of the X ray diffraction line from the lattice plane of the Miller Index (002) of the 100 mol % AlN single crystal thin film directly formed on this substrate is 112 seconds when the substrate which consists of a sintered compact which comprises an aluminum oxide as the main ingredients and which contains a magnesium ingredient 0.60 mol % by MgO conversion, and a silicon ingredient 0.20 mol % by SiO₂ conversion and contains further a yttrium ingredient 0.040 mol % by Y₂O₃ conversion besides these was used, the half width of the rocking curve of the X ray diffraction line from the lattice plane of the Miller Index (002) of the 100 mol % AlN single crystal thin film which was formed furthermore on the 100 mol % AlN orientated polycrystalline thin film which was formed beforehand on the substrate which consists of a sintered compact which comprises an aluminum oxide as the main ingredients and contains a same ingredient is 91 seconds, the crystallinity improved.

While the half width of the rocking curve of the X ray diffraction line from the lattice plane of the Miller Index (002) of the 100 mol % AlN single crystal thin film directly formed on this substrate is 107 seconds when the substrate which consists of a sintered compact which comprises an aluminum oxide as the main ingredients and which contains a magnesium ingredient 1.0 mol % by MgO conversion, and a calcium ingredient 0.20 mol % by CaO conversion and contains further a yttrium ingredient 0.040 mol % by Y₂O₃ conversion besides these was used, the half width of the rocking curve of the X ray diffraction line from the lattice plane of the Miller Index (002) of the 100 mol % AlN single crystal thin film which was formed furthermore on the 100 mol % AlN orientated polycrystalline thin film which was formed beforehand on the substrate which consists of a sintered compact which comprises an aluminum oxide as the main ingredients and contains a same ingredient is 88 seconds, the crystallinity improved.

While the half width of the rocking curve of the X ray diffraction line from the lattice plane of the Miller Index (002) of the 100 mol % GaN single crystal thin film directly formed on this substrate is 107 seconds when the substrate which consists of a sintered compact which comprises an aluminum oxide as the main ingredients and which contains a magnesium ingredient 1.0 mol % by MgO conversion and a calcium ingredient 0.20 mol % by CaO conversion and besides these, further contains an erbium ingredient 0.040 mol % by Er₂O₃ conversion was used, the half width of the rocking curve of the X ray diffraction line from the lattice plane of the Miller Index (002) of the 100 mol % GaN single crystal thin film which was formed furthermore on the 100 mol % GaN orientated polycrystalline thin film which was formed beforehand on the substrate which consists of a sintered compact which comprises an aluminum oxide as the main ingredients and contains a same ingredient is 89 seconds, the crystallinity improved.

Although it is not indicated in Table 48, on the substrate which consists of a sintered compact of various compositions which comprises an aluminum oxide as the main ingredients and which was produced in this Example and is shown in Table 48, not only a 100 mol % AlN orientated polycrystalline thin film but also the thin film of a 100 mol % AlN is formed beforehand in the thickness of 3 μm by the same conditions as the MOCVD method which was performed in experiment No. 709 and the sputtering method performed in experiment No. 706 and 707 of Example 25, the thin film which comprises an aluminum nitride as the main ingredients and is an amorphous state, a polycrystalline state, and a single crystal state which are same as Example 25 was formed, respectively.

The thin film of a 100 mol % GaN was formed beforehand in the thickness of 3 μm according to the same conditions as the MOCVD method which was performed in experiment No. 728 and 730, and the thin film which comprises a gallium nitride as the main ingredients and is an amorphous state and an orientated polycrystal which are same as Example 25 was formed, respectively.

The thin film of a 100 mol % InN was formed beforehand in the thickness of 3 μm according to the same conditions as the MOCVD method which was performed in experiment No. 731, and the thin film which comprises an indium nitride as the main ingredients and is the same orientated polycrystalline state as Example 25 was formed.

Moreover, using the above mentioned substrate which consists of a sintered compact which comprises an aluminum oxide as the main ingredients and formed beforehand the thin film which comprises an aluminum nitride as the main ingredients, the thin film which comprises a gallium nitride as the main ingredients, and the thin film which comprises an indium nitride as the main ingredients, and the substrate which consists of a sintered compact which comprises an aluminum oxide as the main ingredients and which was left without forming a thin film, the single crystal thin films of each composition of 100 mol % AlN, 100 mol % GaN, 100 mol % InN, 50 mol % AlN+50 mol % GaN, and 50 mol % GaN+50 mol % InN were formed furthermore on it in the thickness of 3 [im by the same MOCVD method as what was described in Example 19.

Also when the thin film of the above-mentioned constitution was formed on the substrate which consists of a sintered compact which is same as what was shown in Table 48 and comprises an aluminum oxide as the main ingredients, it was confirmed that it has the same effect as the thing in which the constitution is that the thin film formed beforehand is a 100 mol % AlN orientated polycrystal and that the thin film formed furthermore on it is a 100 mol % AlN or a 100 mol % GaN single crystal thin film.

For example, as for the crystallinity of the single crystal thin film formed furthermore on the formed beforehand thin film which comprises as the main ingredients at least one or more materials selected from a gallium nitride, an indium nitride, and an aluminum nitride and has various crystallized state, such as an amorphous state, a polycrystal, an orientated polycrystal, and a single crystal etc., it was confirmed that it is superior to the crystallinity of the single crystal thin film which comprises as the main ingredients at least one or more materials selected from a gallium nitride, an indium nitride, and an aluminum nitride and which was directly formed on the same substrate which consists of a sintered compact which comprises an aluminum oxide as the main ingredients.

Thus, in this Example, when the substrate which consists of a sintered compact which comprises an aluminum oxide as the main ingredients is used, as for the crystallinity of the single crystal thin film which comprises as the main ingredients at least one or more materials selected from a gallium nitride, an indium nitride, and an aluminum nitride and which is formed furthermore on it after beforehand forming the thin film which comprises as the main ingredients at least one or more materials selected from a gallium nitride, an indium nitride, and an aluminum nitride and has various crystallized state, such as an amorphous state, a polycrystal, an orientated polycrystal, and a single crystal etc., on this substrate, it was confirmed that the thing whose crystallinity is superior to the crystallinity of the single crystal thin film which was directly formed on this substrate and comprises as the main ingredients at least one or more materials selected from a gallium nitride, an indium nitride, and an aluminum nitride is obtained in all experiments.

In this Example, although the appearance of the thin film of a constitution of having indicated in Table 48 and all the thin films produced in addition to this was investigated, defects, such as a crack and a crevice, are not seen in all the thin films formed beforehand on the substrate and the thin films formed furthermore on it.

Although the exfoliation test by pressure sensitive adhesive tape was performed, in all thin films, exfoliation was not seen between the substrates which consists of a sintered compact which comprises an aluminum oxide as the main ingredients, and between thin films.

Although the thin film conductivity material of Ti/Pt/Au was formed on the thin film of the surface of a substrate, the metal lead was soldered and perpendicular tensile strength was investigated, it all is not less than 2 Kg/mm², so it has joined firmly between the sintered compact which comprises an aluminum oxide as the main ingredients and the thin film formed beforehand on this substrate, and between this thin film and the thin film formed furthermore on it.

### EXAMPLE 33

This Example shows the example in which the optical permeability is investigated about the substrate which consists of a sintered compact which comprises as the main ingredients a zirconium dioxide, a magnesium oxide, a magnesium aluminate, and a yttrium oxide, the thin film which comprises as the main ingredients at least one or more materials selected from a gallium nitride, an indium nitride, and an aluminum nitride and has at least one of the crystallized states selected from an amorphous state, a polycrystal, an orientated polycrystal, and a single crystal is formed beforehand using these substrates, then formation of the single crystal thin film which comprises as the main ingredients at least one or more materials selected from a gallium nitride, an indium nitride, and an aluminum nitride on it was tried.

As for the substrate which consists of a sintered compact which comprises as the main ingredients a zirconium dioxide, a magnesium oxide, and a magnesium aluminate, two kinds, i.e., the sintered compact produced in Example 1 and what was produced using the newly produced sintered compact in this Example, were prepared, respectively.

The substrate which consists of a sintered compact which comprises a yttrium oxide as the main ingredients was newly produced in this Example.

In this Example, the sintered compact which comprises as the main ingredients a zirconium dioxide, a magnesium oxide, a magnesium aluminate, and a yttrium oxide by the method shown below was newly produced.

That is, the raw material of a zirconium dioxide which includes Y₂O₃ 3 mol % as the same stabilization agent as what was used in Example 1 was prepared, sintering aids were not added to raw material powder like Example 1, but paraffine wax was added, and the powder for molding was produced, it degreased after molding this powder by a uniaxial press, a hot press was carried out under the pressure of 150 Kg/cm² at 1400 degrees C. for 2 hours in air, thus the sintered compact which comprises a zirconium dioxide as the main ingredients was produced.

Next, the same magnesium oxide raw material as what was used in Example 1 was prepared, CaO and Y₂O₃ were added by 1 weight %, respectively, as sintering aids, and pulverization mixture was carried out by a ball mill like Example 1, then it degreased after molding the powder which added paraffine wax was carried out by a uniaxial press, normal pressure sintering was carried out at 1600 degrees C. for 6 hours in air, thus the sintered compact which comprises a magnesium oxide as the main ingredients was produced.

Next, the same magnesium aluminate raw material as what was used in Example 1 is prepared, CaO and Y₂O₃ were added by 0.1 weight %, respectively, as sintering aids, and pulverization mixture was carried out by a ball mill like the case of magnesium oxide, then paraffine wax was added and the powder for molding was produced, it degreased after a uniaxial press molding, normal pressure sintering was carried out at 1650 degrees C. for 8 hours in hydrogen current, thus the sintered compact which comprises a magnesium aluminate as the main ingredients was produced.

Next, the Y₂O₃ powder, Dy₂O₃ powder, and Ho₂O₃ powder were prepared, i.e., these are same as what was used in Example 30, the paraffine wax was added after pulverization by a ball mill by using only the above-mentioned Y₂O₃ powder as the main ingredients, so the powder for fabrication was produced, it degreased after a uniaxial press molding, normal pressure sintering was carried out at 1600 degrees C. for 3 hours in hydrogen current, thus the sintered compact which comprises a yttrium oxide as the main ingredients was produced.

In the other, Dy₂O₃ and Ho₂O₃ powder were added to the above-mentioned Y₂O₃ powder of 99.5 weight % by 0.25 weight %, respectively, as sintering aids, and pulverization mixture was carried out by a ball mill, so the powder for fabrication was produced by adding the paraffine wax, it degreased after a uniaxial press molding, normal pressure sintering was carried out at 2100 degrees C. for 3 hours in hydrogen current, thus the sintered compact which comprises a yttrium oxide as the main ingredients was produced.

Next, specular surface polish of each sintered compact produced in Example 1 and this Example is carried out using the abradant which consists of a colloidal aluminum oxide of 0.05 μm of particle diameter after grinding processing, they were washed by acetone and iso propyl alcohol, and disk-like substrate with a diameter of 25.4 mm and a thickness of 0.5 mm was produced.

Although the optical permeability to the light with a wavelength 605 nm was measured about the substrate produced like this, it was confirmed that all substrates have optical permeability.

After that, the thin film which comprises as the main ingredients at least one or more materials selected from a gallium nitride, an indium nitride, and an aluminum nitride and which has at least one of the crystallized states selected from an amorphous state, a polycrystal, and an orientated polycrystal, was formed beforehand on these substrates in the thickness of 3 μm by the same method as Example 27, then the formation of the single crystal thin film of the thickness of 3 μm which comprises as the main ingredients at least one or more materials selected from a gallium nitride, an indium nitride, and an aluminum nitride was tried on it.

Consequently, it was confirmed that a single crystal thin film can clearly be formed on the substrate which consists of a sintered compact which was produced in this Example and comprises as the main ingredients a zirconium dioxide, a magnesium oxide, and a magnesium aluminate.

These results were shown in Table 49.

As for the substrate which consists of a sintered compact which comprises as the main ingredients a zirconium dioxide, a magnesium oxide, a magnesium aluminate, and a yttrium oxide, it was confirmed that the thing which is not more than 10 nm can also be produced as average surface roughness Ra.

As for the substrate which consists of a sintered compact which was produced in this Example and comprises as the main ingredients a magnesium oxide and a zirconium dioxide, it was confirmed that the thing which is not more than 5 nm can be produced as average surface roughness Ra.

It was confirmed that what is also not less than 20% can be produced as optical transmissivity, i.e., that is 59% at maximum in the case of the substrate which consists of a sintered compact which comprises a zirconium dioxide as the main ingredients, that is 83% at maximum in the case of the substrate which consists of a sintered compact which comprises a magnesium oxide as the main ingredients, that is 79% at maximum in the case of the substrate which consists of a sintered compact which comprises a magnesium aluminate as the main ingredients, and that is 82% at maximum in the case of the substrate which consists of a sintered compact which comprises a yttrium oxide as the main ingredients.

If the thin film which comprises as the main ingredients at least one or more materials selected from a gallium nitride, an indium nitride, and an aluminum nitride is each crystallized state of an amorphous state, a polycrystal, and an orientated polycrystal, it was confirmed that it can be formed directly on the substrate which consists of a sintered compact which comprises as the main ingredients a zirconium dioxide, a magnesium oxide, a magnesium aluminate, and a yttrium oxide.

After the thin film which is at least one of the crystallized states selected from an amorphous state, a polycrystal, and an orientated polycrystal and which comprises as the main ingredients at least one or more materials selected from a gallium nitride, an indium nitride, and an aluminum nitride was formed beforehand, if the thin film which comprises as the main ingredients at least one or more materials selected from a gallium nitride, an indium nitride, and an aluminum nitride is formed on it, this thin film can form the thing of a single crystal state, it was confirmed that the thing of crystallinity which is not more than 200 seconds altogether can form as half width of the rocking curve of the X ray diffraction line from the lattice plane of the Miller Index (002) of this single crystal thin film.

In the substrate of average surface roughness of not more than 5 nm, it was confirmed that the half width of the rocking curve of the X ray diffraction line from the lattice plane of the Miller Index (002) of this single crystal thin film can form what is not more than 150 seconds altogether as crystallinity.

In this Example, although the appearance of all the thin films of a constitution which was indicated in Table 49 was investigated, defects, such as a crack and a crevice, are not seen both in the thin film which was formed beforehand on the substrate, and the thin film which was formed furthermore on it.

Although the exfoliation test by pressure sensitive adhesive tape was performed, in all thin films, exfoliation was not seen between the substrates which consists of a sintered compact which comprises an aluminum oxide as the main ingredients, and between thin films.

Although the thin film conductivity material of Ti/Pt/Au was formed on the thin film of the surface of a substrate, the metal lead was soldered and perpendicular tensile strength was investigated, it all is not less than 2 Kg/mm², so it has joined firmly between the sintered compact which comprises as the main ingredients a zirconium dioxide, a magnesium oxide, a magnesium aluminate, and a yttrium oxide and the thin film formed beforehand on this substrate, and between this thin film and the thin film formed furthermore on it.

### EXAMPLE 34

This Example shows the example which investigated the luminous efficiency of the produced light emitting device by using the sintered compact which comprises an aluminum nitride as the main ingredients as a substrate.

First, by using the sintered compact produced in this invention which comprises an aluminum nitride as the main ingredients as a substrate, that from which composition (aluminum nitride quantitative formula) and optical transmissivity differ, respectively was prepared.

And, what has a conduction via was prepared.

The form of the prepared substrate has the shape of disk with a diameter of 25.4 mm and thickness of 0.5 mm, and specular surface polish and subsequent washing have been performed.

The thin film which comprises as the main ingredients selected from a gallium nitride or an aluminum nitride and has at least one of the crystallized states selected from an amorphous state, a polycrystal, an orientated polycrystal, and a single crystal was formed suitably on the prepared substrate in the thickness of 3 μm as the thin film of the 1st layer by the same sputtering method or the MOCVD method as what was shown in experiment No. 706, 707, 708, 709 and 730 in Example 25.

After that, on the substrate in which these thin films were formed, the single crystal thin film which comprises as the main ingredients one selected from a gallium nitride or an aluminum nitride was formed furthermore suitably in the thickness of 3 μm as the thin film of the 2nd layer by the same method as what was shown in Example 1.

Each thin film conductivity material of Cr, Mo, W, W/Cu alloy, Ru, Rh, Pd, Os, Ir, Pt, Ti, and Ni was formed suitably on the prepared another substrate in the thickness of 0.5 μm by the same sputtering method as what was shown in Example 18 and Example 20, the orientated polycrystalline thin film which comprises as the main ingredients at least one or more materials selected from a gallium nitride or an aluminum nitride was formed furthermore suitably on this thin film conductivity material in the thickness of 3 μm as the thin film of the 1st layer by the same sputtering method or the MOCVD method as what was shown in experiment No. 708 and 730 in Example 25.

The single crystal thin film which comprises as the main ingredients at least one or more materials selected from a gallium nitride, and an aluminum nitride was formed furthermore suitably on it in the thickness of 3 μm as the thin film of the 2nd layer by the same MOCVD method as what was shown in Example 1.

Production of a light emitting device was tried by using these substrates in which the thin film which comprises as the main ingredients one selected from a gallium nitride or an aluminum nitride and/or each thin film conductivity material of Cr, Mo, W, W/Cu alloy, Ru, Rh, Pd, Os, Ir, Pt, Ti, and Ni were formed on the sintered compact which comprises an aluminum nitride as the main ingredients.

In order to compare, the sapphire substrate being marketed by KYOCERA Corp. in which the substrate surface is C plane (namely, C axis is perpendicular to a substrate surface), the diameter is 25.4 mm, thickness is 0.5 mm, and average surface roughness Ra is 1.2 nm, is also prepared, production of a light emitting device was tried on it.

The characteristic of each above-mentioned substrate used for light emitting device production was shown in Table 50.

The origin of the substrate used in this Example (produced experiment No.) is also shown in Table 50.

The optical transmissivity of each substrate in Table 51 is a thing to light with a wavelength of 605 nm.

Next, each prepared above-mentioned substrate was put into the reaction container of the same MOCVD equipment as what was used in Example 1, preliminary heating was performed at 950 degrees C.-1050 degrees C., passing H₂.

After that, by using trimethyl gallium for a gallium raw material, using H₂ for career gas, and using NH₃ for reactive gas, the GaN film was formed on each above-mentioned substrate as a buffer layer in the thickness of 500 A at 520 degrees C. as the substrate temperature by the MOCVD method of the same equipment as what was used in above-mentioned Example 1.

On the formed buffer layer, a Si doping epitaxial growth GaN thin film which becomes a contact layer and the barrier layer of a single quantum well was formed in the thickness of 5 μm using trimethyl gallium as the main raw material, and furthermore using SiH₄ gas as a raw material for doping ingredient by the MOCVD method of the same conditions as the above except having made substrate temperature into 1000 degrees C.

On it, 2 ingredient mixture composition thin film of undoped epitaxial growth InGaN which becomes a well layer of the single quantum well which is a luminescence layer was formed in the thickness of 30A by using trimethyl gallium and trimethyl indium as the main raw material without using doping ingredient by the MOCVD method of the same conditions as the above except having made substrate temperature into 800 degrees C.

As for the composition of the InGaN thin film which becomes a luminescence layer, three kinds of things, i.e., In0.06Ga0.94N, In0.20Ga0.80N, and In0.45Ga0.55N, were produced.

On it, the thin film of epitaxial growth Al0.20Ga0.80N composition of Mg doping which becomes a barrier layer of a single quantum well was formed in the thickness of 0.15 μm by using trimethyl gallium and trimethyl aluminum as the main raw material, and further using Bis-cyclopentadienyl magnesium (MgCp₂) as a raw material for doping ingredient by the MOCVD method of the same conditions as the above except having made substrate temperature into 1050 degrees C.

On it, the epitaxial growth GaN thin film of Mg doping which becomes a contact layer was formed in the thickness of 0.5 μm by using trimethyl gallium as the main raw material, and further using Bis-cyclopentadienyl magnesium (MgCp₂) as a raw material for doping ingredient by the MOCVD method of the same conditions as the above except having made substrate temperature into 1000 degrees C.

After that, the substrate in which the thin film was formed was extracted from a reaction container, it was heated at 700 degrees C. in N₂.

Next, the mask of predetermined form was formed on Mg doping P type GaN thin film layer produced like that, etching was performed until the GaN thin film layer of the above-mentioned Si doping was exposed, the electrode was produced by two layers of metal thin films of Ti/Al on the GaN thin film layer of this Si doping.

The electrode was produced by two layers of metal thin films of Ni/Au on the Mg doping GaN thin film layer currently formed in the top layer.

After that, the substrate on which the thin film was formed was cut into the chip of an outside size of 1 mm×1 mm, the light emitting diode (LED) of single quantum well structure was produced.

What used the substrate which does not form the thin film layer among the produced light emitting diodes is what has a constitution so that it may illustrate in FIG. 42.

What used the substrate in which only one layer of thin film layers was formed is what has a constitution so that it may illustrate in FIG. 43.

What used the substrate in which two layers of thin film layers were formed is what has a constitution so that it may illustrate in FIG. 44.

What used the substrate which formed thin film conductivity material and formed furthermore two layers of thin film layers is what has a constitution so that it may illustrate in FIG. 53.

The electrode is formed by arrangement which is illustrated in FIG. 45.

As for what used the substrate which has a conduction via, electrode formation by the above etching was not performed, the light emitting device of the single quantum well structure of the form which has arranged the electrode to the upper and lower sides of a light emitting device was produced by forming not the GaN thin film layer of Si doping but an electrode with three layers of metal thin films of Ti/Pt/Au on the sintered compact which comprises an aluminum nitride as the main ingredients as shown in FIG. 47-FIG. 49, and FIG. 54-FIG. 56.

The size of the light emitting device chip of the form which has arranged the electrode up and down is also outside of 1 mm×1 mm.

The light emitting diode produced using the sapphire substrate is a constitution as shown in FIG. 40, and the electrode is formed by arrangement which is illustrated in FIG. 45 like the light emitting diode produced using the substrate which consists of a sintered compact which comprises an aluminum nitride as the main ingredients.

Next, among the produced light emitting diodes, direct-current potential was applied and luminescence was tried by using that whose composition of the InGaN thin film which becomes a luminescence layer is In0.20Ga0.80N.

Consequently, luminescence with a main wavelength 450 nm was obtained by applying the voltage of 3.5 volts-3.8 volts into light emitting diode produced.

Next, as for all the light emitting diodes which have the above-mentioned luminescence layer and have single quantum well structure, the actuating current which was inputted in order to make this diode drive and the luminescence output which was emitted from a light emitting device at the time were measured, and luminous efficiency was calculated.

The result was shown in experiment No. 1421-experiment No. 1457 of Table 50.

Experiment No. 1457 of Table 50 is a result of the light emitting diode produced using the sapphire substrate.

The actuating current of Table 50 is a value at the time of having made a light emitting diode drive on the operating voltage of 3.6 volts.

Consequently, in the case of the light emitting diode of the single quantum well structure produced using the sapphire substrate, luminous efficiency was 6.7%, but in the case of the light emitting diode which was produced using the substrate according to this invention which consists of a sintered compact which comprises an aluminum nitride as the main ingredients, luminous efficiency was not less than 10% altogether.

As shown in Table 50, the optical transmissivity of a sapphire substrate is not less than 90%, and is very high.

On the other hand, even if the substrate which consists of a sintered compact which comprises an aluminum nitride as the main ingredients is what does not have optical transmissivity or what is the optical transmissivity not more than 10%, the luminous efficiency of the light emitting device produced using this substrate which consists of a sintered compact which comprises an aluminum nitride as the main ingredients is not less than 10%, it is larger than the light emitting device produced using a sapphire substrate.

Even if it is the light emitting diode produced using a substrate as it is without forming beforehand a gallium nitride and an aluminum nitride thin film onto the substrate according to this invention which consists of a sintered compact which comprises an aluminum nitride as the main ingredients, the luminous efficiency was not less than 10%.

Furthermore, the luminous efficiency of the light emitting diode produced by using the substrate on which at least one or more layers of a gallium nitride or an aluminum nitride were formed improved.

If using the substrate of the two layer constitution of thin films, wherein the thin film which comprises a gallium nitride or an aluminum nitride as the main ingredients and has at least one of the crystallized states selected from an amorphous state, a polycrystal, an orientated polycrystal, and a single crystal was formed beforehand on the substrate which consists of a sintered compact which comprises an aluminum nitride as the main ingredients, and furthermore the single crystal thin film which comprises a gallium nitride or an aluminum nitride as the main ingredients was formed on it, it was confirmed that the luminous efficiency of the light emitting device formed on this substrate improves further than the substrate in which only one layer of thin films was formed. Furthermore, if using the substrate of the two layer constitution of thin films, wherein the thin film which comprises as the main ingredients a gallium nitride or an aluminum nitride and has at least one of the crystallized states selected from an amorphous state, a polycrystal, an orientated polycrystal, and a single crystal was formed beforehand on the substrate which consists of a sintered compact which comprises an aluminum nitride as the main ingredients and contains an aluminum nitride ingredient not less than 20 volume %, and furthermore the single crystal thin film which comprises a gallium nitride or an aluminum nitride as the main ingredients was formed on it, it was confirmed that the thing in which the luminous efficiency of the light emitting device produced on it is not less than 12% is obtained.

When using the substrate on which the thin film which comprises as the main ingredients a gallium nitride or an aluminum nitride and has at least one of the crystallized states selected from an amorphous state, a polycrystal, an orientated polycrystal, and a single crystal was formed beforehand on the substrate which consists of a sintered compact which comprises an aluminum nitride as the main ingredients and contains an aluminum nitride ingredient not less than 50 volume %, it was confirmed that the thing in which the luminous efficiency of the light emitting device produced on it is not less than 12% is obtained.

When using the substrate on which the thin film of the orientated polycrystalline state which comprises as the main ingredients a gallium nitride or an aluminum nitride was formed beforehand on the substrate which consists of a sintered compact which comprises an aluminum nitride as the main ingredients and contains an aluminum nitride ingredient not less than 50 volume %, it was confirmed that the thing in which the luminous efficiency of the light emitting device produced on it is not less than 15% is obtained.

If using the substrate of the two layer constitution of thin films, wherein the thin film which comprises as the main ingredients a gallium nitride or an aluminum nitride and has at least one of the crystallized states selected from an amorphous state, a polycrystal, an orientated polycrystal, and a single crystal was formed beforehand on the substrate which consists of a sintered compact which comprises an aluminum nitride as the main ingredients and contains an aluminum nitride ingredient not less than 50 volume %, and furthermore the single crystal thin film which comprises a gallium nitride or an aluminum nitride as the main ingredients was formed on it, it was confirmed that the thing in which the luminous efficiency of the light emitting device produced on it is not less than 15% is obtained.

In this Example, even if the substrate which consists of a sintered compact which comprises as the main ingredients an aluminum nitride is the optical transmissivity smaller than 1% or does not have optical permeability substantially, or the substrate which is the optical transmissivity not less than 1%, are used, the light emitting device which is the luminous efficiency at least not less than 10% was producible.

And, the more the optical transmissivity of the above-mentioned substrate was large, the more the luminous efficiency of the light emitting device produced on this substrate improves.

That is, when the sintered compact which comprises an aluminum nitride as the main ingredients and which is the optical transmissivity not less than 10% is used as a substrate, it was confirmed that the thing in which the luminous efficiency of the light emitting device produced on it is not less than 12% is obtained.

And, when the sintered compact which comprises an aluminum nitride as the main ingredients and which is the optical transmissivity not less than 20% is used as a substrate, it was confirmed that the thing in which the luminous efficiency of the light emitting device produced on it is not less than 15% is obtained.

And, when the sintered compact which comprises an aluminum nitride as the main ingredients and which is the optical transmissivity not less than 30% is used as a substrate, it was confirmed that the thing in which the luminous efficiency of the light emitting device produced on it is not less than 20% is obtained.

And, when the sintered compact which comprises an aluminum nitride as the main ingredients and which is the optical transmissivity not less than 40% is used as a substrate, it was confirmed that the thing in which the luminous efficiency of the light emitting device produced on it is not less than 25% is obtained.

And, when the sintered compact which comprises an aluminum nitride as the main ingredients and which is the optical transmissivity not less than 50% is used as a substrate, it was confirmed that the thing in which the luminous efficiency of the light emitting device produced on it is not less than 30% is obtained.

And, when the sintered compact which comprises an aluminum nitride as the main ingredients and which has the optical permeability of optical transmissivity not less than 60% is used as a substrate, it was confirmed that the thing in which the luminous efficiency of the light emitting device produced on it is not less than 40% is obtained.

In this Example, when the substrate which consists of a sintered compact which comprises an aluminum nitride as the main ingredients and whose optical transmissivity is 88% is used, the light emitting device which has the greatest luminous efficiency of 62% in this Example was produced on it.

Also in the light emitting diode produced using the substrate according to this invention which consists of a sintered compact which comprises an aluminum nitride as the main ingredients and which formed the thin film conductivity material, luminous efficiency was not less than 10% altogether.

As for the light emitting diode produced by using the substrate on which thin film conductivity material was formed, most luminescence from the substrate side was not seen, but luminescence from the direction of the P type GaN thin film layer which is opposite side and the luminescence layer side was observed.

The luminous efficiency of the light emitting diode produced using the substrate on which thin film conductivity material was formed did not lower than the luminous efficiency of the light emitting diode produced using the substrate which does not form this thin film conductivity material by the same substrate.

Even if it was the light emitting device of the form which arranged the electrode up and down which was produced by using the substrate which has a conduction via, the tendency which lowers luminous efficiency was not seen especially, but it was confirmed that it can be enough used as a light emitting diode.

Although it is not indicated in Table 50, in the case of the light emitting diode of the single quantum well structure which produced composition of the InGaN thin film used as a luminescence layer as In0.06Ga0.94N and In0.45Ga0.55N, though main luminescence wavelength changed to 390 nm and 520 nm, respectively, in the case of the light emitting diode produced using the substrate according to this invention which consists of a sintered compact which comprises an aluminum nitride as the main ingredients, all things are luminous efficiency not less than 10% like the thing whose composition of a luminescence layer is In0.20Ga0.80N, and the luminous efficiency was higher if it is compared with that whose light emitting diodes produced using the sapphire substrate has been respectively 6.6% and 6.1%.

Next, in the other, the light emitting device of double hetero structure was produced using the prepared above-mentioned substrate which comprises a ceramic material as the main ingredients, and the sapphire substrate prepared for comparing.

That is, the prepared above-mentioned substrate was put into the reaction container of the same MOCVD equipment as what used in Example 1, preliminary heating was performed at 950 degrees C.-1050 degrees C., passing H₂.

After that, by using trimethyl gallium for a gallium raw material, using H₂ for career gas, and using NH₃ for reactive gas, the GaN film was formed on each above-mentioned substrate as a buffer layer in the thickness of 500A at 500 degrees C. as the substrate temperature by the MOCVD method of the same equipment as what was used in above-mentioned Example 1.

On the formed buffer layer, the epitaxial growth GaN thin film of Si doping which becomes a contact layer and the barrier layer of a single quantum well was formed in the thickness of 4 μm by using trimethyl gallium as the main raw material, and further using SiH₄ gas as a raw material for doping ingredient by the MOCVD method of the same conditions as the above except having made substrate temperature into 1050 degrees C.

On it, the thin film of epitaxial growth Al0.15Ga0.85N composition of Si doping which becomes a cladding layer was formed in the thickness of 0.15 μm by using trimethyl gallium and trimethyl aluminum as the main raw material, and further using SiH₄ gas as a raw material for doping ingredient by the MOCVD method of the same conditions as the above except having made substrate temperature into 1050 degrees C.

On it, the thin film of epitaxial growth In0.06Ga0.94N composition which becomes a luminescence layer was formed in the thickness of 500 A by using trimethyl gallium and trimethyl indium as the main raw material, and further using SiH₄ gas and diethyl zinc as a raw material for doping ingredient by the MOCVD method of the same conditions as the above except having made substrate temperature into 800 degrees C.

On it, the thin film of epitaxial growth A10.15Ga0.85N composition of Mg doping which becomes a cladding layer was formed in the thickness of 0.15 Jim by using trimethyl gallium and trimethyl aluminum as the main raw material, and further using Bis-cyclopentadienyl magnesium (MgCp₂) as a raw material for doping ingredient by the MOCVD method of the same conditions as the above except having made substrate temperature into 1050 degrees C.

On it, the epitaxial growth GaN thin film of Mg doping which becomes a contact layer was formed in the thickness of 0.5 μm by using trimethyl gallium as the main raw material, and further using Bis-cyclopentadienyl magnesium (MgCp₂) as a raw material for doping ingredient by the MOCVD method of the same conditions as the above except having made substrate temperature into 1050 degrees C.

After that, the substrate in which the thin film was formed was extracted from a reaction container, it was heated at 700 degrees C. in N₂.

Next, the mask of predetermined form was formed on Mg doping P type GaN thin film layer produced like that, etching was performed until the GaN thin film layer of the above-mentioned Si doping was exposed, the electrode was produced by two layers of metal thin films of Ti/Al on the GaN thin film layer of this Si doping.

On the Mg doping GaN thin film layer currently formed in the top layer, the electrode was produced by two layers of metal thin films of Ni/Au.

After that, the substrate on which the thin film was formed was cut into the chip of an outside size of 1 mm×1 mm, the light emitting diode (LED) of double hetero structure was produced.

Among the produced light emitting diodes, what used the substrate in which two layers of thin film layers were formed is what has a constitution so that it may illustrate to FIG. 57.

What used the substrate which does not form the thin film layer is what has the constitution in which the thin film 5 and the thin film layer 8 are not formed in FIG. 57.

What used the substrate which formed thin film conductivity material and formed furthermore two layers of thin film layers is what has a constitution in which thin film conductivity material was formed between the substrate 4 and the thin film layer 5 in FIG. 57.

The electrode is formed by arrangement which is illustrated in FIG. 45.

As for what used the substrate which has a conduction via, electrode formation by the above etching was not performed, the light emitting device of the double hetero structure of the form which has arranged the electrode to the upper and lower sides of a light emitting device was produced by forming not the GaN thin film layer of Si doping but an electrode with three layers of metal thin films of Ti/Pt/Au on the sintered compact which comprises an aluminum nitride as the main ingredients as shown in FIG. 47-FIG. 49, and FIG. 54-FIG. 56.

The light emitting diode produced using the sapphire substrate is a constitution as shown in FIG. 41, and the electrode is formed by arrangement which is illustrated in FIG. 45 like the light emitting diode produced using the substrate which consists of a sintered compact which comprises an aluminum nitride as the main ingredients.

Next, direct-current potential was applied to the produced light emitting diode, and luminescence was tried.

Luminescence with a main wavelength 450 nm was obtained in any produced light emitting diode by applying the voltage of 3.5 volts-3.8 volts.

Next, as for all the produced above-mentioned light emitting diodes of double hetero structure, the actuating current which was inputted in order to make this diode drive and the luminescence output which was emitted from a light emitting device at the time were measured, and luminous efficiency was calculated.

The result was shown in experiment No. 1458-experiment No. 1467 of Table 50.

Experiment No. 1467 of Table 50 are as a result of the light emitting diode produced using the sapphire substrate.

The actuating current of Table 50 is a value at the time of having made a light emitting diode drive on the operating voltage of 3.6 volts.

Consequently, in the case of the light emitting diode of the double hetero structure produced using the sapphire substrate, luminous efficiency was 5.4%, but in the case of the light emitting diode of the double hetero structure which was produced using the substrate according to this invention which consists of a sintered compact which comprises an aluminum nitride as the main ingredients, luminous efficiency was not less than 10% altogether.

As shown in Table 50, the optical transmissivity of a sapphire substrate is not less than 90%, and is very high.

On the other hand, even if the substrate which consists of a sintered compact which comprises an aluminum nitride as the main ingredients is what does not have optical transmissivity or what is the optical transmissivity not more than 10%, the luminous efficiency of the light emitting device produced using this substrate which consists of a sintered compact which comprises an aluminum nitride as the main ingredients is not less than 10%, it is larger than the light emitting device produced using a sapphire substrate.

Even if it is the light emitting diode produced using a substrate as it is without forming beforehand a gallium nitride and an aluminum nitride thin film onto the substrate according to this invention which consists of a sintered compact which comprises an aluminum nitride as the main ingredients, the luminous efficiency was not less than 10%.

Furthermore, the luminous efficiency of the light emitting diode produced using the substrate on which at least one or more layers of a gallium nitride or an aluminum nitride were formed improved.

If the substrate of a two layer constitution of thin films on which the thin film which comprises as the main ingredients a gallium nitride or an aluminum nitride and has at least one of the crystallized states selected from an amorphous state, a polycrystal, an orientated polycrystal, and a single crystal was formed beforehand on the substrate which consists of a sintered compact which comprises an aluminum nitride as the main ingredients, and the single crystal thin film which comprises a gallium nitride or an aluminum nitride as the main ingredients was formed furthermore on it is used, it was confirmed that the luminous efficiency of the light emitting device formed on this substrate improves further than the substrate in which only one layer of thin films was formed.

Next, the 100 mol % AlN orientated polycrystalline thin film with a thickness of 3 μm was first formed by using the same sputtering method as Example 25 by using as a substrate the substrate which comprises an aluminum nitride as the main ingredients and was produced in experiment No. 49 of Example 2.

After that, the substrate was taken out from the sputtering chamber, and the 100 mol % AlN single crystal thin film in which C axis is a perpendicular direction to the substrate surface was formed at a thickness of 25 μm by the same MOCVD method as Example 1.

The half width of the rocking curve of the X ray diffraction line from the lattice plane of the Miller Index (002) of this AlN single crystal thin film was 84 seconds.

Specular surface polish of the formed AlN single crystal thin film was carried out by the abradant which comprises as the main ingredients a chromic oxide of particle diameter of 0.1 μm and the abradant which comprises as the main ingredients the colloidal SiO₂ of particle diameter of 0.02 μm, and ultrasonic washing was carried out with acetone and iso propyl alcohol, and the thin film substrate of average surface roughness Ra 1.2 nm was produced.

The AlN single crystal thin film of the surface after polish remained by the thickness of 9 μm.

The laser diode was produced by using this thin film substrate as a substrate for light emitting device production, and further by using the above-mentioned sapphire substrate in order to compare.

SiO₂ film for performing the ELO method on a buffer layer was not formed on the used sapphire substrate, sapphire was used in the state as it is.

The above-mentioned two kinds of substrates prepared like that was put in the reaction container of the same MOCVD equipment as what used in Example 1, preliminary heating was performed at 1000 degrees C., passing H₂.

After that, by using trimethyl gallium for a gallium raw material, using H₂ for career gas, and using NH3 for reactive gas, the GaN film was formed on each above-mentioned substrate as a buffer layer in the thickness of 500 A at 500 degrees C. as the substrate temperature by the MOCVD method of the same equipment as what was used in above-mentioned Example 1.

On the formed buffer layer, the epitaxial growth GaN thin film of Si doping which becomes a contact layer was formed in the thickness of 6 μm by using trimethyl gallium as the main raw material, and further using SiH₄ gas as a raw material for doping ingredient by the MOCVD method of the same conditions as the above except having made substrate temperature into 1050 degrees C.

On it, the thin film of epitaxial growth Al0.15Ga0.85N composition of Si doping which becomes the 2nd cladding layer was formed in the thickness of 0.1 μm by using trimethyl gallium and trimethyl aluminum as the main raw material, and further using SiH₄ gas as a raw material for doping ingredient by the MOCVD method of the same conditions as the above except having made substrate temperature into 1050 degrees C.

On it, the epitaxial growth Al0.15Ga0.85N thin film and GaN thin film, in which Si was doped respectively are laminated by turns respectively in the thickness of 20 A into 150 layers by using trimethyl gallium and trimethyl aluminum as the main raw material, and further using SiH₄ gas as a raw material for doping ingredient by the MOCVD method of the same conditions as the above except having made substrate temperature into 1050 degrees C., and the super lattice layer was formed.

On it, the epitaxial growth GaN thin film of Si doping which becomes the first cla layer was formed in the thickness of 0.1 μm by using trimethyl gallium as the main raw material, and further using SiH₄ gas as a raw material for doping ingredient by the MOCVD method of the same conditions as the above except having made substrate temperature into 1000 degrees C.

On it, the multi-quantum-well of the epitaxial grown In0.15Ga0.85N(Si doping)/In0.02Ga0.98N(Si doping) which becomes a luminescence layer was formed by using trimethyl gallium and trimethyl indium as the main raw material, and further using SiH₄ gas as a raw material for doping ingredient by the MOCVD method of the same conditions as the above except having made substrate temperature into 800 degrees C.

6 layers of In0.15Ga0.85N thin film with a thickness of 30 A which becomes a well layer and 5 layers of In0.02Ga0.98N thin films with a thickness of 85 A which becomes a barrier layer are laminated by turns, respectively, the constitution of this multi-quantum-well was formed.

On it, the epitaxial growth GaN thin film of Mg doping which becomes the 1st cladding layer was formed in the thickness of 0.1 μm by using trimethyl gallium as the main raw material, and further using Bis-cyclopentadienyl magnesium (MgCp₂) as a raw material for doping ingredient by the MOCVD method of the same conditions as the above except having made substrate temperature into 1000 degrees C.

On it, the epitaxial growth Al0.15Ga0.85N thin film and GaN thin film, in which Mg was doped respectively are laminated by turns respectively in the thickness of 20 A into 150 layers by using trimethyl gallium and trimethyl aluminum as the main raw material, and further using Bis-cyclopentadienyl magnesium (MgCp₂) as a raw material for doping ingredient by the MOCVD method of the same conditions as the above except having made substrate temperature into 1050 degrees C., and the super lattice layer was formed.

On it, the thin film of epitaxial growth Al0.15Ga0.85N composition of Mg doping which becomes the 2nd cladding layer was formed in the thickness of 0.05 μm by using trimethyl gallium and trimethyl aluminum as the main raw material, and further using Bis-cyclopentadienyl magnesium (MgCp₂) as a raw material for doping ingredient by the MOCVD method of the same conditions as the above except having made substrate temperature into 1050 degrees C.

On it, the epitaxial growth GaN thin film of Mg doping which becomes a contact layer was formed in the thickness of 0.2 μm by using trimethyl gallium as the main raw material, and further using Bis-cyclopentadienyl magnesium (MgCp₂) as a raw material for doping ingredient by the MOCVD method of the same conditions as the above except having made substrate temperature into 1000 degrees C.

After that, the substrate in which the thin film was formed was extracted from a reaction container, it was heated at 700 degrees C. in N₂.

Next, after taking out from thermal treatment equipment, the mask of the form which can form a strip electrode as shown in FIG. 46 was formed on the Mg dope P type GaN thin film layer of the top layer, etching was performed until the GaN thin film layer of the above-mentioned Si doping was exposed, the strip electrode as shown in FIG. 46 was produced by two layers of metal thin films of Ti/Al on the GaN thin film layer of this Si doping.

The strip electrode with a width of 10 μm which was shown in FIG. 46 was produced by two layers of metal thin films of Ni/Au on the Mg doping GaN thin film layer which is being formed in the top layer.

After electrode formation, the substrate was cut into the chip of a size of 0.45 mm×0.45 mm, specular surface polish of the cut both-ends side perpendicular to the longitudinal direction of a strip electrode was carried out, and a mirror was formed, the laser diode was produced.

Next, direct-current potential was applied to the produced laser diode, and luminescence was tried.

Consequently, as for what was produced using conventional sapphire as a substrate, the oscillation of the laser light with the 402 nm wavelength and 8 mW outputs was confirmed under the 4.7 volts operating voltage and 70 mA actuating current.

Thus, the luminous efficiency of the laser diode produced using conventional sapphire as a substrate was 2.4%.

On the other hand, in the case of the laser diode which was produced using the thin film substrate according to this invention and which formed the AlN single crystal thin film on the surface of the substrate which consists of a sintered compact which comprises an aluminum nitride as the main ingredients, the oscillation of the laser light with the 402 nm wavelength and 49 mW outputs was confirmed under the 4.3 volts operating voltage and 70 mA actuating current.

Thus, the luminous efficiency of the laser diode which was produced using the thin film substrate according to this invention which consists of a sintered compact which comprises an aluminum nitride as the main ingredients was 16.3%.

A GaN film was formed on a sapphire substrate in the thickness of 500 A as a buffer layer like the above, What formed strip SiO2 thin film with a width of 10 μm at intervals of 10 μm on it was prepared as a substrate, production of the laser diode by the ELO method was tried.

It is 0.1 μm in thickness of this SiO₂ thin film.

Thus, by using the sapphire substrate which formed beforehand the strip SiO₂ thin film at equal intervals, the GaN thin film of Si doping which becomes a contact layer was formed first by the same method as the above, after that, the laser diode was produced by the same method as the above, and luminescence was tried.

The electrode formed on the P type GaN thin film layer of the produced laser diode was formed in the position equivalent to the space portion of strip SiO₂ thin film in which dislocation and distortion in the epitaxial thin film of a gallium nitride, an indium nitride, and an aluminum nitride is considered to be little.

Consequently, in this laser diode, the oscillation of the laser light with the 402 nm wavelength and 22 mW outputs was observed under the 4.4 volts operating voltage and 70 mA actuating current.

Luminous efficiency is 7.1%.

Thus, when a conventional sapphire substrate is used, luminous efficiency was comparatively small even if it was the laser diode produced using the ELO method.

### EXAMPLE 35

This Example shows the example which investigated the luminous efficiency, by performing the trial of production of a light emitting device by using the sintered compact which comprises as the main ingredients each of a silicon carbide, a silicon nitride, a zinc oxide, a beryllium oxide, an aluminum oxide, a zirconium dioxide, a magnesium oxide, a magnesium aluminate, and a yttrium oxide as a substrate.

First, each sintered compact produced in this invention which comprises as the main ingredients a silicon carbide, silicon nitride, a zinc oxide, a beryllium oxide, an aluminum oxide, a zirconium dioxide, magnesium oxide, a magnesium aluminate, and a yttrium oxide was used as a substrate, that from which composition (content of each ceramic main ingredients) and optical transmissivity differ, respectively was prepared.

The form of the prepared substrate has the shape of disk with a diameter of 25.4 mm and thickness of 0.5 mm, and specular surface polish and subsequent washing have been performed.

The thin film which comprises as the main ingredients one selected from a gallium nitride or an aluminum nitride and has at least one of the crystallized states selected from an amorphous state, a polycrystal, an orientated polycrystal, and a single crystal was formed suitably on the prepared substrate in the thickness of 3 μm as the thin film of the 1st layer by the same sputtering method or the MOCVD method as what was shown in experiment No. 706, 707, 708, 709 and 730 in Example 25.

After that, on the substrate in which these thin films were formed, the single crystal thin film which comprises as the main ingredients one selected from a gallium nitride or an aluminum nitride was formed furthermore suitably in the thickness of 3 μm as the thin film of the 2nd layer by the same method as what was shown in Example 1.

The characteristic of each above-mentioned substrate used for light emitting device production was shown in Table 51.

The origin of the substrate used in this Example (produced experiment No.) is also shown in Table 51.

The optical transmissivity of each substrate in Table 51 is a thing to light with a wavelength of 605 nm.

Hereafter, production of the light emitting device of single quantum well structure was tried like Example 34 by using each substrate prepared in this Example.

That is, each prepared above-mentioned substrate was put into the reaction container of the same MOCVD equipment as what was used in Example 1, preliminary heating was performed at 950 degrees C.-1050 degrees C., passing H₂.

After that, by using trimethyl gallium for a gallium raw material, using H₂ for career gas, and using NH3 for reactive gas, the GaN film was formed on each above-mentioned substrate as a buffer layer in the thickness of 500 A at 520 degrees C. as the substrate temperature by the MOCVD method of the same equipment as what was used in above-mentioned Example 1.

On the formed buffer layer, the epitaxial growth GaN thin film of Si doping which becomes a contact layer and the barrier layer of a single quantum well was formed in the thickness of 5 Jim by using trimethyl gallium as the main raw material, and further using SiH₄ gas as a raw material for doping ingredient by the MOCVD method of the same conditions as the above except having made substrate temperature into 1000 degrees C.

On it, 2 ingredient mixture composition thin film of undoped epitaxial growth InGaN which becomes a well layer of the single quantum well which is a luminescence layer was formed in the thickness of 30 A by using trimethyl gallium and trimethyl indium as the main raw material without using doping ingredient by the MOCVD method of the same conditions as the above except having made substrate temperature into 800 degrees C.

As for the composition of the InGaN thin film which becomes a luminescence layer, three kinds of things, i.e., In0.06Ga0.94N, In0.20Ga0.80N, and In0.45Ga0.55N, were produced.

On it, the thin film of epitaxial growth Al0.20Ga0.80N composition of Mg doping which becomes a barrier layer of a single quantum well was formed in the thickness of 0.15 μm by using trimethyl gallium and trimethyl aluminum as the main raw material, and further using Bis-cyclopentadienyl magnesium (MgCp₂) as a raw material for doping ingredient by the MOCVD method of the same conditions as the above except having made substrate temperature into 1050 degrees C.

On it, the epitaxial growth GaN thin film of Mg doping which becomes a contact layer was formed in the thickness of 0.5 μm by using trimethyl gallium as the main raw material, and further using Bis-cyclopentadienyl magnesium (MgCp₂) as a raw material for doping ingredient by the MOCVD method of the same conditions as the above except having made substrate temperature into 1000 degrees C.

After that, the substrate in which the thin film was formed was extracted from a reaction container, it was heated at 700 degrees C. in N₂.

Next, the mask of predetermined form was formed on Mg doping P type GaN thin film layer produced like that, etching was performed until the GaN thin film layer of the above-mentioned Si doping was exposed, the electrode was produced by two layers of metal thin films of Ti/Al on the GaN thin film layer of this Si doping.

The electrode was produced by two layers of metal thin films of Ni/Au on the Mg doping GaN thin film layer currently formed in the top layer.

After that, the substrate on which the thin film was formed was cut into the chip of an outside size of 1 mm×1 mm, the light emitting diode (LED) of single quantum well structure was produced.

What used the substrate which does not form the thin film layer among the produced light emitting diodes is what has a constitution so that it may illustrate in FIG. 42.

What used the substrate in which only one layer of thin film layers was formed is what has a constitution so that it may illustrate in FIG. 43.

What used the substrate in which two layers of thin film layers were formed is what has a constitution so that it may illustrate in FIG. 44.

The electrode is formed by arrangement which is illustrated in FIG. 45, it is the same as that of the light emitting diode produced using the substrate which consists of a sintered compact which comprises an aluminum nitride as the main ingredients in Example 34.

The light emitting device produced in experiment No. 1490 and experiment No. 1492 uses as a substrate the sintered compact which comprises a zinc oxide as the main ingredients and has conductivity, the thin film formed beforehand on a substrate also used the GaN thin film which has the conductivity of Si doping.

The constitution of the light emitting diode produced in experiment No. 1490 and experiment No. 1492 is like what is shown in FIG. 50, electrode formation by the above etching is not performed, it is the light emitting diode of the single quantum well structure of the form which has arranged the electrode to the upper and lower sides of a light emitting device by directly forming three layers of metal thin films of Ti/Pt/Au on each sintered compact which comprises a zinc oxide as the main ingredients.

The size of the light emitting diode chip of the form which has arranged the electrode up and down is also outside 1 mm×1 mm.

Next, among the produced light emitting diodes, direct-current potential was applied and luminescence was tried by using that whose composition of the InGaN thin film which becomes a luminescence layer is In0.20Ga0.80N.

Consequently, luminescence with a main wavelength 450 nm was obtained by applying the voltage of 3.5 volts-3.8 volts into light emitting diode produced.

Next, as for all the light emitting diodes which have the above-mentioned luminescence layer and have single quantum well structure, the actuating current which was inputted in order to make this diode drive and the luminescence output which was emitted from a light emitting device at the time were measured, and luminous efficiency was calculated.

The result was shown in Table 51.

The actuating current of Table 51 is a value at the time of having made a light emitting diode drive on the operating voltage of 3.6 volts.

Consequently, in the case of the light emitting diode which is the single quantum well structure and which was produced using the sapphire substrate, luminous efficiency was 6.7% as shown in Example 34, but in the case of the light emitting diode produced using the substrate according to this invention which consists of each sintered compact which comprises as the main ingredients each of a silicon carbide, a silicon nitride, a zinc oxide, a beryllium oxide, an aluminum oxide, a zirconium dioxide, a magnesium oxide, a magnesium aluminate, and a yttrium oxide, the luminous efficiency was not less than 8% altogether, it was higher than what was produced using the sapphire substrate.

As shown in Table 50 of Example 34, the optical transmissivity of a sapphire substrate is not less than 90%, and is very high.

On the other hand, even if the substrate which consists of each sintered compact which comprises as the main ingredients each of a silicon carbide, a silicon nitride, a zinc oxide, a beryllium oxide, an aluminum oxide, a zirconium dioxide, a magnesium oxide, a magnesium aluminate, and a yttrium oxide is what does not have optical transmissivity or what is the optical transmissivity not more than 10%, the luminous efficiency of the light emitting device produced by using this substrate which consists of a sintered compact which comprises as the main ingredients each of a silicon carbide, a silicon nitride, a zinc oxide, a beryllium oxide, an aluminum oxide, a zirconium dioxide, a magnesium oxide, and a magnesium aluminate is not less than 8%, it is larger than the light emitting device produced using a sapphire substrate.

Even if it is the light emitting diode produced using a substrate as it is without forming beforehand a gallium nitride and an aluminum nitride thin film onto the substrate according to this invention which consists of a sintered compact which comprises a zinc oxide as the main ingredients, the luminous efficiency was not less than 8%.

Furthermore, the luminous efficiency of the light emitting diode produced by using the substrate on which at least one or more layers of a gallium nitride or an aluminum nitride were formed improved.

If the substrate of the two layer constitution of thin films on which the thin film which comprises as the main ingredients a gallium nitride or an aluminum nitride and has at least one of the crystallized states selected from an amorphous state, a polycrystal, an orientated polycrystal, and a single crystal was formed beforehand on the substrate which consists of a sintered compact which comprises as the main ingredients each of a silicon carbide, a silicon nitride, a zinc oxide, a beryllium oxide, an aluminum oxide, a zirconium dioxide, a magnesium oxide, and a magnesium aluminate, and the single crystal thin film which comprises a gallium nitride or an aluminum nitride as the main ingredients was formed furthermore on it is used, it was confirmed that the luminous efficiency of the light emitting device formed on this substrate improves further than the substrate in which only one layer of thin films was formed on the substrate which consists of a sintered compact which comprises as the main ingredients each of a silicon carbide, a silicon nitride, a zinc oxide, a beryllium oxide, an aluminum oxide, a zirconium dioxide, a magnesium oxide, a magnesium aluminate, and a yttrium oxide.

In this Example, the content of the zinc oxide ingredient in the sintered compact which comprises a zinc oxide as the main ingredients and was used for light emitting diode production is not less than 55.0 mol %, it was confirmed that the luminous efficiency of the light emitting diode produced using the substrate which consists of this sintered compact is not less than 8%.

The content of the beryllium oxide ingredient in the sintered compact which comprises a beryllium oxide as the main ingredients and was used for light emitting diode production is not less than 65.0 mol %, and it was confirmed that the luminous efficiency of the light emitting diode produced using the substrate which consists of this sintered compact is not less than 8%.

The content of the aluminum oxide ingredient in the sintered compact which comprises an aluminum oxide as the main ingredients and was used for light emitting diode production is not less than 55.0 mol %, and it was confirmed that the luminous efficiency of the light emitting diode produced using the substrate which consists of this sintered compact is not less than 8%.

In this invention, even if the substrate according to this invention which consists of a sintered compact which comprises as the main ingredients each silicon carbide, silicon nitride, zinc oxide, beryllium oxide, aluminum oxide, zirconium dioxide, magnesium oxide, magnesium aluminate, and yttrium oxide is the optical transmissivity smaller than 1% or does not have optical permeability substantially, or the substrate whose optical transmissivity is not less than 1%, are used, the light emitting device whose luminous efficiency is not less than 8% was producible.

It was confirmed that the luminous efficiency of the light emitting device produced on this substrate improves in what has the large optical transmissivity of the above-mentioned substrate.

That is, in each sintered compact which comprises as the main ingredients a silicon carbide, a silicon nitride, a zinc oxide, a beryllium oxide, an aluminum oxide, a zirconium dioxide, a magnesium oxide, a magnesium aluminate, and a yttrium oxide, when the thing whose optical transmissivity is not less than 10% is used as a substrate, it was confirmed that the thing in which the luminous efficiency of the light emitting device produced on it is not less than 10% is obtained.

Moreover, in each sintered compact which comprises as the main ingredients a silicon carbide, a silicon nitride, a zinc oxide, a beryllium oxide, an aluminum oxide, a zirconium dioxide, a magnesium oxide, a magnesium aluminate, and a yttrium oxide, when the thing whose optical transmissivity is not less than 20% is used as a substrate, it was confirmed that the thing in which the luminous efficiency of the light emitting device produced on it is not less than 12% is obtained.

Moreover, in each sintered compact which comprises as the main ingredients a silicon carbide, a silicon nitride, a zinc oxide, a beryllium oxide, an aluminum oxide, a zirconium dioxide, a magnesium oxide, a magnesium aluminate, and a yttrium oxide, when the thing whose optical transmissivity is not less than 30% is used as a substrate, it was confirmed that the thing in which the luminous efficiency of the light emitting device produced on it is not less than 15% is obtained.

Moreover, in each sintered compact which comprises as the main ingredients a silicon carbide, a silicon nitride, a zinc oxide, a beryllium oxide, an aluminum oxide, a zirconium dioxide, a magnesium oxide, a magnesium aluminate, and a yttrium oxide, when the thing whose optical transmissivity is not less than 40% is used as a substrate, it was confirmed that the thing in which the luminous efficiency of the light emitting device produced on it is not less than 20% is obtained.

Moreover, in each sintered compact which comprises as the main ingredients a silicon carbide, a silicon nitride, a zinc oxide, a beryllium oxide, an aluminum oxide, a zirconium dioxide, a magnesium oxide, a magnesium aluminate, and a yttrium oxide, when the thing whose optical transmissivity is not less than 50% is used as a substrate, it was confirmed that the thing in which the luminous efficiency of the light emitting device produced on it is not less than 25% is obtained.

When each sintered compact which comprises as the main ingredients a silicon carbide, a silicon nitride, a zinc oxide, a beryllium oxide, an aluminum oxide, a zirconium dioxide, a magnesium oxide, a magnesium aluminate, and a yttrium oxide and which has the optical permeability of optical transmissivity not less than 60% is used as a substrate, it was confirmed that the thing in which the luminous efficiency of the light emitting device produced on it is not less than 30% is obtained.

In this Example, when the substrate which consists of a sintered compact which comprises a zinc oxide as the main ingredients and whose optical transmissivity is 84% is used, the light emitting device which has the greatest luminous efficiency of 55% in this Example was produced on it.

In this Example, when the substrate which consists of a sintered compact which comprises a beryllium oxide as the main ingredients and whose optical transmissivity is 81% is used, the light emitting device which has 52% as luminous efficiency was produced on it.

In this Example, when the substrate which consists of a sintered compact which comprises an aluminum oxide as the main ingredients and whose optical transmissivity is 82% is used, the light emitting device which has 51% as luminous efficiency was produced on it.

In this Example, when the substrate which consists of a sintered compact which comprises a zirconium dioxide as the main ingredients and whose optical transmissivity is 59% is used, the light emitting device which has 27% as luminous efficiency was produced on it.

In this Example, when the substrate which consists of a sintered compact which comprises a magnesium oxide as the main ingredients and whose optical transmissivity is 83% is used, the light emitting device which has 51% as luminous efficiency was produced on it.

In this Example, when the substrate which consists of a sintered compact which comprises a magnesium aluminate as the main ingredients and whose optical transmissivity is 81% is used, the light emitting device which has 50% as luminous efficiency was produced on it.

In this Example, when the substrate which consists of a sintered compact which comprises a yttrium oxide as the main ingredients and whose optical transmissivity is 83% is used, the light emitting device which has 51% as luminous efficiency was produced on it.

Even if it is the light emitting device of the form which arranged the electrode up and down which was produced by using the substrate which comprises a zinc oxide as the main ingredients and has conductivity, the tendency which lowers luminous efficiency was not seen especially, but it was confirmed that it can be enough used as a light emitting diode.

In the other, although only composition of the InGaN film which becomes a luminescence layer was replaced with In0.20Ga0.80N into In0.06Ga0.94N and In0.45Ga0.55N, and the light emitting diode of single quantum well structure was produced using the substrate according to this invention which consists of each sintered compact which comprises as the main ingredients a silicon carbide, a silicon nitride, a zinc oxide, a beryllium oxide, an aluminum oxide, a zirconium dioxide, a magnesium oxide, and a magnesium aluminate, except that main luminescence wavelength changed with 390 nm and 520 nm, respectively, all the things were luminous efficiency not less than 8% like the light emitting diode whose composition of the luminescence layer produced in the beginning of this Example is In0.20Ga0.80N.

In the other, the light emitting diode of the same double hetero structure as Example 34 was produced by using as a substrate each prepared above-mentioned sintered compact which comprises as the main ingredients a silicon carbide, a silicon nitride, a zinc oxide, a beryllium oxide, an aluminum oxide, a zirconium dioxide, a magnesium oxide, a magnesium aluminate, and a yttrium oxide.

All the substrates shown in Table 51 were used on the occasion of production of this light emitting diode.

As a substrate which was used for light emitting diode production, it is what was made into a thin film substrate by forming the thin film as shown in Table 51 on each sintered compact which comprises as the main ingredients a silicon carbide, a silicon nitride, a zinc oxide, a beryllium oxide, an aluminum oxide, a zirconium dioxide, a magnesium oxide, a magnesium aluminate, and a yttrium oxide.

Consequently, in all the produced light emitting diodes of double hetero structure, luminous efficiency is not less than 8%, since the luminous efficiency of the light emitting diode of double hetero structure which was produced in Example 34 using the sapphire as the substrate was 5.4%, it was excelled clearly.

The Example explained the 1 st aspect of this invention above.

In addition, it has been explained that what has optical permeability can be used as the substrate for thin film formation, the thin film substrate, or the substrate for light emitting device production in the sintered compact according to this invention which comprises as the main ingredients a ceramic material, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc.

In this invention, “the sintered compact which comprises a ceramic material as the main ingredients and which has optical permeability” usually means the sintered compact which comprises a ceramic material as the main ingredients and which is the optical transmissivity not less than 1%.

Although even if the above-mentioned sintered compact which comprises a ceramic material as the main ingredients has optical permeability, it is difficult to form directly the single crystal thin film which comprises as the main ingredients at least one or more materials selected from a gallium nitride, an indium nitride, and an aluminum nitride in many cases, if at least one of thin films which are selected from an amorphous state, a polycrystalline state, and an orientated polycrystalline state and comprise as the main ingredients at least one or more materials selected from a gallium nitride, an indium nitride, and an aluminum nitride is formed beforehand, even if the optical transmissivity of the sintered compact is smaller than 1% or is 0%, the single crystal thin film which comprises as the main ingredients at least one or more materials selected from a gallium nitride, an indium nitride, and an aluminum nitride can be formed on the above-mentioned sintered compact which comprises a ceramic material as the main ingredients.

In this invention, even if the optical transmissivity of the sintered compact is smaller than 1% or is 0% lamination of the thin film which comprises as the main ingredients at least one or more materials selected from the group consisting of the epitaxially grown gallium nitride, indium nitride, and aluminum nitride is attained on the sintered compact which comprises a ceramic material as the main ingredients and which formed at least one of the above-mentioned thin films selected from a single crystal, an amorphous state, a polycrystal, and an orientated polycrystal, a light emitting device in which the luminous efficiency is at least equivalent or more can be produced if it is compared with the light emitting device produced by using a conventional sapphire substrate etc. as a result.

TABLE 1

| | Characteristics of the substrate consisting | | | | Characteristics of the thin | | | |
|---|---|---|---|---|---|---|---|---|
| | of various sintered compacts | | | | film formed on the sintered compact | | | |
| | | | Main | Average | | | | Half width |
| | | Firing | constitution | surface | | | | of the (002) |
| | Main | conditions | phase | roughness | | | | X ray |
| | ingredient | at the time | of | of the | | Thickness | | diffraction |
| Experi- | of | of | the obtained | substrate | Composition | of the | | rocking |
| ment | the sintered | sintered ompact | sintered | Ra | of | thin film | X ray | curve |
| No. | compact | production | compact | (nm) | the thin film | (μm) | diffraction pattern | (second) |
| 1 | Aluminum | 1950° C. × 2 | AlN | 67 | 100% GaN | 0.25 | only (002) diffraction line | 239 |
| 2 | nitride | hours | | | 100% InN | 0.25 | only (002) diffraction line | 290 |
| 3 | | in N₂ | | | 100% AlN | 0.25 | only (002) diffraction line *) | — |
| 4 | | Normal pressure | | | 100% AlN | 6.0 | only (002) diffraction line | 189 |
| 5 | | sintering | | | 50 mol % GaN + | 3.0 | only (002) diffraction line | 196 |
| | | | | | 50 mol % AlN | | | |
| 6 | | 1850° C. × 2 | AlN | 64 | 100% GaN | 0.25 | only (002) diffraction line | 275 |
| 7 | | hours | | | 100% InN | 0.25 | only (002) diffraction line | 247 |
| 8 | | in N₂ | | | 100% AlN | 0.25 | only (002) diffraction line *) | — |
| 9 | | Hot press | | | 100% AlN | 6.0 | only (002) diffraction line | 195 |
| 10 | | (300 atm) | | | 100% AlN | 3.0 | only (002) diffraction line | 229 |
| 11 | Silicon | 2050° C. × 3 hours | α-SiC | 59 | 100% GaN | 0.25 | only (002) diffraction line | 920 |
| 12 | carbide | in Ar | | | 100% InN | 0.25 | only (002) diffraction line | 970 |
| 13 | | Normal pressure | | | 100% AlN | 0.25 | only (002) diffraction line | 287 |
| | | sintering | | | | | | |
| 14 | Silicon | 1770° C. × 3 hours | β-Si₃N₄ + | 55 | 100% GaN | 0.25 | only (002) diffraction line | 890 |
| 15 | nitride | in N₂ | 6.6% of | | 100% InN | 0.25 | only (002) diffraction line | 760 |
| 16 | | Gas pressure | unknown | | 100% AlN | 0.25 | only (002) diffraction line | 447 |
| | | sintering | phase | | | | | |
| | | (9.4 atm) | | | | | | |
| 17 | Aluminum | 1600° C. × 3 hours | α-Al₂O₃ | 42 | 100% GaN | 0.25 | only (002) diffraction line | 521 |
| 18 | oxide | in air | | | 100% InN | 0.25 | only (002) diffraction line | 545 |
| 19 | | Normal pressure | | | 100% AlN | 0.25 | only (002) diffraction line | 366 |
| | | sintering | | | | | | |
| 20 | Zirconium | 1500° C. × 3 hours | ZrO₂ | 36 | 100% GaN | 0.25 | (002) diffraction line + (100) | — |
| | dioxide | in air | (Tetragonal) | | | | diffraction line | |
| 21 | | Normal pressure | | | 100% AlN | 0.25 | (002) diffraction line + (100) | — |
| | | sintering | | | | | diffraction line | |
| 22 | Zinc oxide | 1350° C. × 3 hours | ZnO | 119 | 100% GaN | 0.25 | only (002) diffraction line | 1780 |
| 23 | | in air | | | 100% InN | 0.25 | only (002) diffraction line | 3270 |
| 24 | | Normal pressure | | | 100% AlN | 0.25 | only (002) diffraction line | 960 |
| | | sintering | | | | | | |
| 25 | Magnesium | 1550° C. × 3 hours | MgO | 60 | 100% GaN | 0.25 | (002) diffraction line + (100) | — |
| | oxide | in air | | | | | diffraction line | |
| 26 | | Normal pressure | | | 100% InN | 0.25 | (002) diffraction line + (100) | — |
| | | sintering | | | | | diffraction line | |
| 27 | Beryllium | 1500° C. × 3 hours | BeO | 108 | 100% GaN | 0.25 | only (002) diffraction line | 2240 |
| 28 | oxide | in air | | | 100% InN | 0.25 | only (002) diffraction line | 2970 |
| 29 | | Normal pressure | | | 100% AlN | 0.25 | only (002) diffraction line | 910 |
| | | sintering | | | | | | |
| 30 | Magnesium | 1600° C. × 3 hours | MgAl₂O₄ | 63 | 100% GaN | 0.25 | (002) diffraction line + (100) | — |
| | aluminate | in air | | | | | diffraction line | |
| 31 | | Normal pressure | | | 100% AlN | 0.25 | (002) diffraction line + (100) | — |
| | | sintering | | | | | diffraction line | |

*) using a electron beam diffraction

TABLE 2

| | Characteristics of the substrate consisting of a sintered compact comprising an aluminum nitride as the main ingredients | | | | | | | | | |
|---|---|---|---|---|---|---|---|---|---|---|
| | | | | Characteristics of the sintered compact comprising an | | | | | | |
| | Characteristics of | | | aluminum nitride as the main ingredients | | | | | | |
| | the powder compact | | | | | Average | | | Degree | |
| | Additive | | | | | size | Total | | of | |
| | Additive | Amount | | | | of | amount | Amount | surface | |
| | name | of | | Relative | Average | the AlN | of | of | smoothness | Optical |
| Experiment | in the powder | addition | Firing | density | pore size | particle | oxygen | ALON | Ra | transmissivity |
| No. | compact | (volume %) *1) | conditions *3) | (%) | (μm) | (μm) | (weight %) | (%) | (nm) | (%) |
| 32 | none | — | (1) | 99.4 | <0.5 | 11.2 | 0.8 | 1.6 | 32 | 28 |
| 33 | none | — | (2) | 99.6 | <0.5 | 16.7 | 0.7 | 1.5 | 34 | 46 |
| 34 | none | — | (3) | 99.6 | <0.5 | 4.5 | 1.0 | 2.1 | 35 | 52 |
| 35 | none | — | (4) | 99.7 | <0.5 | 8.9 | 0.9 | 1.8 | 32 | 49 |
| 36 | none | — | (5) | 99.2 | 0.5 | 8.4 | 0.8 | 1.7 | 32 | 19 |
| 37 | Al₂O₃ | 2.0 | (1) | 99.3 | 0.5 | 11.6 | 2.1 | 5.7 | 36 | 8.4 |
| 38 | Al₂O₃ | 7.0 | (1) | 98.6 | 0.5 | 10.9 | 4.9 | 13.4 | 37 | 5.4 |
| 39 | Al₂O₃ | 12.0 | (1) | 98.3 | 0.7 | 9.7 | 7.4 | 19.0 | 37 | 4.0 |
| 40 | Al₂O₃ | 20.0 | (1) | 98.4 | 0.6 | 12.3 | 11.9 | 25.5 | 41 | 0.6 |
| 41 | CaCO₃ | 0.01 | (6) | 99.4 | <0.5 | 4.2 | 0.9 | 1.2 | 31 | 16 |
| 42 | Y₂O₃ | 0.02 | (6) | 99.1 | 0.5 | 3.9 | 0.9 | 1.3 | 35 | 7.4 |
| 43 | Y₂O₃ | 0.1 | (6) | 99.3 | <0.5 | 4.0 | 0.9 | 1.3 | 29 | 10.6 |
| 44 | Y₂O₃ | 0.1 | (3) | 99.7 | <0.5 | 2.5 | 1.0 | 1.2 | 27 | 22 |
| 45 | CaCO₃ | 0.5 | (6) | 99.1 | 0.6 | 4.7 | 1.1 | 0.0 | 33 | 12 |
| 46 | CaCO₃ | 0.5 | (3) | 99.6 | <0.5 | 2.7 | 1.1 | 0.0 | 29 | 55 |
| 47 | Y₂O₃ | 1.0 | (6) | 99.4 | <0.5 | 4.5 | 1.3 | 0.0 | 30 | 25 |
| 48 | CaCO₃ | 3.0 | (6) | 99.2 | 0.6 | 5.0 | 2.4 | 0.0 | 32 | 23 |
| 49 | Y₂O₃ | 3.3 | (6) | 99.5 | <0.5 | 2.9 | 1.9 | 0.0 | 26 | 34 |
| 50 | Y₂O₃ | 5.0 | (6) | 99.4 | <0.5 | 3.3 | 2.4 | 0.0 | 29 | 30 |
| 51 | Y₂O₃ | 12.0 | (6) | 99.0 | 0.5 | 3.5 | 4.2 | 0.0 | 25 | 37 |
| 52 | Y₂O₃ | 15.0 | (3) | 98.9 | 0.6 | 3.9 | 5.0 | 0.0 | 21 | 28 |
| 53 | Y₂O₃ | 25.0 | (6) | 99.1 | <0.5 | 3.8 | 8.2 | 0.0 | 22 | 19 |
| 54 | Gd₂O₃ | 9.0 | (6) | 99.0 | <0.5 | 4.2 | 3.5 | 0.0 | 27 | 29 |
| 55 | Dy₂O₃ | 3.5 | (6) | 99.2 | <0.5 | 3.4 | 2.0 | 0.0 | 28 | 31 |
| 56 | Ho₂O₃ | 3.5 | (6) | 99.2 | <0.5 | 3.4 | 1.9 | 0.0 | 31 | 26 |
| 57 | Er₂O₃ | 1.0 | (6) | 99.3 | <0.5 | 3.0 | 1.2 | 0.0 | 33 | 33 |
| 58 | Er₂O₃ | 3.6 | (6) | 99.1 | <0.5 | 2.9 | 2.1 | 0.0 | 28 | 35 |
| 59 | Er₂O₃ | 10.5 | (6) | 98.8 | 0.5 | 3.7 | 4.1 | 0.0 | 23 | 21 |
| 60 | Yb₂O₃ | 0.5 | (6) | 99.2 | <0.5 | 3.8 | 1.0 | 0.0 | 34 | 17 |
| 61 | Li₂CO₃ | 0.5 | (3) | 99.4 | <0.5 | 2.5 | 0.9 | 1.4 | 45 | 8.4 |
| 62 | Si | 0.02 | (3) | 99.5 | <0.5 | 2.7 | 0.8 | 1.7 | 37 | 26 |
| 63 | Si₃N₄ | 2.5 | (3) | 99.6 | <0.5 | 2.4 | 0.8 | 0.0 | 20 | 13 |
| 64 | MoO₃ | 0.10 *2) | (1) | 99.4 | <0.5 | 9.6 | 0.8 | 1.5 | 30 | 12 |
| 65 | WO₃ | 4.5 *2) | (1) | 99.6 | <0.5 | 9.4 | 0.9 | 1.9 | 28 | 0.0 |
| 66 | Nb₂O₅ | 0.2 *2) | (1) | 99.5 | <0.5 | 11.2 | 0.9 | 1.9 | 28 | 0.2 |
| 67 | TiO₂ | 0.07 *2) | (1) | 99.1 | <0.5 | 12.3 | 0.8 | 1.6 | 30 | 4.5 |
| 68 | C | 0.7 *2) | (1) | 99.0 | <0.5 | 9.1 | 0.4 | 0.9 | 29 | 0.0 |
| 69 | Fe | 0.04 *2) | (1) | 99.3 | <0.5 | 10.7 | 0.8 | 1.5 | 32 | 12 |
| 70 | Ni | 0.6 *2) | (1) | 99.2 | <0.5 | 11.5 | 1.0 | 2.0 | 32 | 0.0 |

*1) Amount of the additive is based on oxide conversion.
*2) Amount of addition of the additive of experiment No. 64-70 is based on element conversion.
*3) Firing conditions:
(1) Normal pressure sintering 1950° C. × 4 hours, in N₂
(2) Gas pressure sintering 1950° C. × 12 hours, in N₂ (9 Kg/cm²)
(3) Hot press 1800° C. × 2 hours, in N₂ (300 Kg/cm²)
(4) HIP firing 1900° C. × 3 hours, (2000 Kg/cm²)
(5) Normal pressure sintering 1900° C. × 4 hours, in N₂
(6) Normal pressure sintering 1800° C. × 1 hour, in N₂

TABLE 3

| | Characteristic of the single crystal thin film formed on | | |
|---|---|---|---|
| | the sintered compact comprising an aluminum nitride | | |
| | as the main ingredients | | |
| | | Thickness of | Half width of the |
| Experi- | Composition | the | (002) X ray |
| ment | of | thin film | diffraction rocking |
| No. | the thin film | (μm) | curve (second) |
| 32 | 100% GaN | 0.25 | 180 |
| 33 | 100% GaN | 0.25 | 142 |
| 34 | 100% GaN | 0.25 | 189 |
| 35 | 100% GaN | 0.25 | 156 |
| 36 | 100% GaN | 0.25 | 175 |
| 37 | 100% GaN | 0.25 | 169 |
| 38 | 100% GaN | 0.25 | 181 |
| 39 | 100% GaN | 0.25 | 187 |
| 40 | 100% GaN | 0.25 | 774 |
| 41 | 100% GaN | 0.25 | 185 |
| 42 | 50 mol % GaN + 50 mol % | 0.25 | 233 |
| | InN | | |
| 43 | 100% InN | 0.25 | 189 |
| 44 | 50 mol % GaN + 50 mol % | 6.0 | 194 |
| | AlN | | |
| 45 | 100% GaN | 0.25 | 188 |
| 46 | 100% GaN | 0.25 | 137 |
| 47 | 100% GaN | 0.25 | 184 |
| 48 | 100% GaN | 0.25 | 179 |
| 49 | 100% GaN | 0.25 | 195 |
| 50 | 20 mol % GaN + 80 mol % | 6.0 | 170 |
| | AlN | | |
| 51 | 100% GaN | 0.25 | 167 |
| 52 | 50 mol % GaN + 50 mol % | 0.25 | 161 |
| | InN | | |
| 53 | 100% GaN | 0.25 | 652 |
| 54 | 100% GaN | 0.25 | 183 |
| 55 | 100% GaN | 0.25 | 194 |
| 56 | 100% GaN | 0.25 | 216 |
| 57 | 100% GaN | 0.25 | 226 |
| 58 | 100% GaN | 0.25 | 167 |
| 59 | 100% GaN | 0.25 | 190 |
| 60 | 100% GaN | 0.25 | 155 |
| 61 | 100% GaN | 0.25 | 224 |
| 62 | 100% GaN | 0.25 | 216 |
| 63 | 100% GaN | 0.25 | 189 |
| 64 | 100% GaN | 0.25 | 169 |
| 65 | 100% GaN | 0.25 | 186 |
| 66 | 100% GaN | 0.25 | 178 |
| 67 | 100% GaN | 0.25 | 199 |
| 68 | 100% GaN | 0.25 | 197 |
| 69 | 100% GaN | 0.25 | 191 |
| 70 | 100% GaN | 0.25 | 179 |

TABLE 4

| | | | Size | Electric | |
|---|---|---|---|---|---|
| | | | of | resistivity of the | Half width of |
| | | | the | conduction via | the (002) X ray |
| | Conduction | | through | (10⁻⁶ Ω · cm) | diffraction |
| Experiment | via | Sintering | hole | (Room | rocking curve |
| No. | materials | aids | (μm) | temperature) | (second) |
| 71 | 100% | Y₂O₃ | 25 | 7.4 | 189 |
| 72 | tungsten | | 50 | 6.9 | 196 |
| 73 | | Er₂O₃ | 25 | 7.7 | 207 |
| 74 | | | 250 | 6.6 | 226 |
| 75 | 50 volume % | Y₂O₃ | 25 | 4.9 | 177 |
| 76 | tungsten + 50 | | 50 | 4.4 | 192 |
| 77 | volume % | Er₂O₃ | 25 | 5.0 | 200 |
| 78 | copper | | 50 | 4.8 | 233 |
| 79 | | CaO | 25 | 5.6 | 167 |
| 80 | 100% | Y₂O₃ | 25 | 3.4 | 201 |
| 81 | copper | | 250 | 2.9 | 223 |
| 82 | | Er₂O₃ | 25 | 3.9 | 225 |
| 83 | | | 50 | 3.1 | 239 |
| 84 | | CaO | 25 | 2.7 | 155 |
| 85 | | | 500 | 2.0 | 174 |

TABLE 5

| | | | | | Half width of |
|---|---|---|---|---|---|
| | | | | | the (002) X ray |
| | | | Thin film | | diffraction |
| Experiment | Sintering | Thin film | thickness | | rocking curve |
| No. | aids | composition | (nm) | X ray diffraction pattern | (second) |
| 86 | Y₂O₃ | 100% GaN | 0.7 | only (002) diffraction line | — |
| 87 | | 100% GaN | 1000 | only (002) diffraction line | 184 |
| 88 | | 100% InN | 2.5 | only (002) diffraction line | 290 |
| 89 | | 100% InN | 1500 | only (002) diffraction line | 159 |
| 90 | | 100% AlN | 25 | only (002) diffraction line | — |
| | | | | *) | |
| 91 | | 50 mol % GaN + 50 mol % | 7.5 | only (002) diffraction line | 290 |
| | | InN | | | |
| 92 | | 50 mol % GaN + 50 mol % | 70 | only (002) diffraction line | 240 |
| | | AlN | | | |
| 93 | Er₂O₃ | 100% GaN | 2.5 | only (002) diffraction line | 260 |
| 94 | | 100% GaN | 80 | only (002) diffraction line | 250 |
| 95 | | 100% InN | 7.0 | only (002) diffraction line | 270 |
| 96 | | 100% InN | 700 | only (002) diffraction line | 166 |
| 97 | | 100% AlN | 4200 | only (002) diffraction line | 179 |
| 98 | | 50 mol % InN + 50 mol % | 5.0 | only (002) diffraction line | 290 |
| | | AlN | | | |
| 99 | | 50 mol % GaN + 50 mol % | 16 | only (002) diffraction line | 290 |
| | | AlN | | | |
| 100 | CaO | 100% GaN | 120 | only (002) diffraction line | 221 |
| 101 | | 100% InN | 6.0 | only (002) diffraction line | 290 |
| 102 | | 50 mol % GaN + 50 mol % | 10 | only (002) diffraction line | 290 |
| | | AlN | | | |

*) based on electron beam diffraction

TABLE 6

| | Characteristics of the substrate consisting of a sintered compact | | | | | | | | | Characteristics of the single | | |
|---|---|---|---|---|---|---|---|---|---|---|---|---|
| | comprising an aluminum nitride as the main ingredients | | | | | | | | | crystal thin film formed | | |
| | Characteristics of | | | | | | | | | on the sintered compacts | | |
| | the powder compact | | | | | | | | | comprising an aluminum nitride | | |
| | The additive | | Characteristics of the produced sintered | | | | | | | as the main ingredients | | |
| | and the | | compact comprising an aluminum | | | | | | | | | Half width |
| | amount of | | nitride as the main ingredients | | | | | | | | | of the |
| | addition | | | | Average | Total | | Degree | | | | (002) |
| | in the | | | | size | amount | | of | | | Thin | X ray |
| | powder | | | Average | of the | of | Amount | surface | | | film | diffraction |
| | compact | Firing | Relative | pore | AlN | oxygen | of | smooth- | Optical | Composition | thick- | rocking |
| Experiment | (volume | conditions | density | size | particle | (weight | ALON | ness | transmissivity | of | ness | curve |
| No. | %) *1) | *3) | (%) | (μm) | (μm) | %) | (%) | Ra (nm) | (%) | the thin film | (μm) | (second) |
| 103 | without | (2) | 99.6 | <0.5 | 3.0 | 0.8 | 1.6 | 27 | 62 | 100% GaN | 0.25 | 127 |
| | additive | | | | | | | | | | | |
| 104 | MgO (0.4) | (1) | 99.6 | <0.5 | 2.4 | 0.9 | 1.5 | 29 | 33 | 50 mol % | 0.25 | 152 |
| | | | | | | | | | | GaN + 50 | | |
| | | | | | | | | | | mol % AlN | | |
| 105 | CaCO₃(0.2) | (2) | 99.6 | <0.5 | 2.5 | 0.9 | 0.5 | 28 | 69 | 100% GaN | 0.25 | 122 |
| 106 | CaCO₃(0.2) | (3) | 99.4 | <0.5 | 2.4 | 0.8 | 0.4 | 27 | 54 | 100% GaN | 0.25 | 134 |
| 107 | Al₂O₃(0.4) | (1) | 99.7 | <0.5 | 2.9 | 1.0 | 2.2 | 29 | 62 | 100% GaN | 0.25 | 140 |
| 108 | Y₂O₃ (0.2) | (2) | 99.7 | <0.5 | 1.9 | 0.8 | 0.6 | 26 | 74 | 100% GaN | 0.25 | 122 |
| 109 | Y₂O₃ (0.2) | (3) | 99.6 | <0.5 | 2.3 | 0.8 | 0.5 | 28 | 56 | 100% GaN | 0.25 | 141 |
| 110 | Er₂O₃(3.0) | (2) | 99.8 | <0.5 | 2.0 | 1.9 | 0.0 | 26 | 67 | 50 mol % | 0.25 | 127 |
| | | | | | | | | | | GaN + 50 | | |
| | | | | | | | | | | mol % InN | | |
| 111 | Er₂O₃(3.0) | (3) | 99.6 | <0.5 | 2.3 | 1.9 | 0.0 | 27 | 58 | 100% GaN | 0.25 | 131 |
| 112 | V₂O₅ (0.5) *2) | (1) | 99.6 | <0.5 | 2.9 | 0.9 | 1.4 | 31 | 0.0 | 100% InN | 0.25 | 157 |
| 113 | Cr₂O₃(1.0) *2) | (1) | 99.4 | <0.5 | 2.2 | 0.8 | 2.0 | 33 | 0.0 | 100% GaN | 0.25 | 186 |

*1) Amount of the additive is based on oxide conversion.
However in experiment No. 112 and 113 marked with *2), it is based on element conversion. And, the amount of addition is shown in ( ).
*3) Firing conditions:
(1) 1820° C. × 2 hours, in 1 atm N₂ Hot press (pressure: 300 Kg/cm²)
(2) 1900° C. × 2 hours, in 1 atm N₂ Hot press (pressure: 300 Kg/cm²)
(3) 1820° C. × 2 hours, inN₂ Normal pressure sintering

TABLE 7

Characteristics of the sintered
compact comprising an aluminum
nitride as the main ingredients

| | | | Ultraviolet-rays |
|---|---|---|---|
| | Used substrates | | transmissivity |
| Experiment | | Experiment | (%) |
| No. | Example | No. | [300 nm] |
| 114 | Example 2 | 32 | 12 |
| 115 | Example 2 | 33 | 24 |
| 116 | Example 2 | 34 | 41 |
| 117 | Example 2 | 35 | 37 |
| 118 | Example 2 | 38 | 3.6 |
| 119 | Example 2 | 44 | 17 |
| 120 | Example 2 | 46 | 44 |
| 121 | Example 2 | 49 | 28 |
| 122 | Example 2 | 54 | 16 |
| 123 | Example 2 | 55 | 21 |
| 124 | Example 2 | 56 | 20 |
| 125 | Example 2 | 58 | 26 |
| 126 | Example 2 | 60 | 8.5 |
| 127 | Example 2 | 61 | 6.2 |
| 128 | Example 2 | 62 | 30 |
| 129 | Example 2 | 67 | 1.9 |
| 130 | Example 2 | 69 | 7.6 |
| 131 | Example 6 | 103 | 49 |
| 132 | Example 6 | 104 | 29 |
| 133 | Example 6 | 105 | 62 |
| 134 | Example 6 | 106 | 46 |
| 135 | Example 6 | 107 | 49 |
| 136 | Example 6 | 108 | 67 |
| 137 | Example 6 | 109 | 50 |
| 138 | Example 6 | 110 | 54 |
| 139 | Example 6 | 111 | 47 |

TABLE 8

| | Characteristics of the sintered compact substrate | | | | | Characteristics of the thin film formed | | |
|---|---|---|---|---|---|---|---|---|
| | | Used substrates | | | | on various sintered compacts | | |
| | | Example which | | | | | | Half width of |
| | | carried out | | | | | Thickness | the (002) X ray |
| | | substrate production | | Surface | Processing state | Composition | of | diffraction |
| Experiment | Main | Example | Experiment | smoothness | in the | of | the thin film | rocking curve |
| No. | ingredient | No. | No. | Ra (nm) | substrate surface | the thin film | (μm) | (second) |
| 140 | Aluminum | Example 1 | 1˜5 | 670 | as-fired | 50 mol % GaN + 50 mol % | 0.25 | 236 |
| | nitride | | | | | InN | | |
| 141 | | | | 1070 | lap | 50 mol % GaN + 50 mol % | 0.25 | 860 |
| | | | | | | InN | | |
| 142 | | | | 34 | specular surface | 50 mol % GaN + 50 mol % | 0.25 | 206 |
| | | | | | | InN | | |
| 143 | | Example 2 | 34 | 530 | lap | 100% AlN | 6.0 | 390 |
| 144 | | | | 25 | specular surface | 100% AlN | 6.0 | 164 |
| 145 | | Example 2 | 46 | 460 | lap | 100% AlN | 6.0 | 292 |
| 146 | | | | 28 | specular surface | 100% AlN | 6.0 | 157 |
| 147 | | Example 2 | 62 | 1260 | lap | 100% AlN | 6.0 | 970 |
| 148 | | | | 22 | specular surface | 100% AlN | 6.0 | 159 |
| 149 | | Example 2 | 64 | 570 | as-fired | 100% AlN | 3.0 | 288 |
| 150 | | | | 1220 | lap | 100% AlN | 3.0 | 1330 |
| 151 | | | | 17 | specular surface | 100% AlN | 3.0 | 134 |
| 152 | | Example 4 | 86˜92 | 96 | as-fired | 100% AlN | 6.0 | 190 |
| 153 | | | | 530 | lap | 100% AlN | 6.0 | 330 |
| 154 | | | | 24 | specular surface | 100% AlN | 6.0 | 150 |
| 155 | | Example 4 | 93˜99 | 270 | as-fired | 100% InN | 0.25 | 212 |
| 156 | | | | 240 | lap | 100% InN | 0.25 | 420 |
| 157 | | | | 29 | specular surface | 100% InN | 0.25 | 171 |
| 158 | | Example 4 | 100˜102 | 210 | as-fired | 50 mol % GaN + 50 mol % | 1.0 | 199 |
| | | | | | | AlN | | |
| 159 | | | | 530 | lap | 50 mol % GaN + 50 mol % | 1.0 | 390 |
| | | | | | | AlN | | |
| 160 | | | | 26 | specular surface | 50 mol % GaN + 50 mol % | 1.0 | 166 |
| | | | | | | AlN | | |
| 161 | | Example 6 | 103 | 330 | lap | 100% AlN | 3.0 | 285 |
| 162 | | | | 16 | specular surface | 100% AlN | 3.0 | 126 |
| 163 | | Example 6 | 105 | 460 | lap | 100% AlN | 6.0 | 370 |
| 164 | | | | 27 | specular surface | 100% AlN | 6.0 | 160 |
| 165 | | Example 6 | 107 | 890 | lap | 100% AlN | 6.0 | 570 |
| 166 | | | | 23 | specular surface | 100% AlN | 6.0 | 161 |
| 167 | | Example 6 | 108 | 320 | lap | 100% AlN | 6.0 | 274 |
| 168 | | | | 22 | specular surface | 100% AlN | 6.0 | 159 |
| 169 | | Example 6 | 109 | 310 | as-fired | 100% GaN | 0.25 | 207 |
| 170 | | | | 300 | lap | 100% GaN | 0.25 | 274 |
| 171 | | | | 27 | specular surface | 100% GaN | 0.25 | 169 |
| 172 | | Example 6 | 110 | 310 | lap | 100% AlN | 3.0 | 282 |
| 173 | | | | 22 | specular surface | 100% AlN | 3.0 | 154 |
| 174 | Silicon | Example 1 | 11˜13 | 820 | lap | 100% AlN | 3.0 | 2670 |
| 175 | carbide | | | 6.8 | specular surface 1 | 100% AlN | 3.0 | 287 |
| 176 | | | | 2.9 | specular surface 2 | 100% AlN | 3.0 | 210 |
| 177 | Silicon | Example 1 | 14˜16 | 140 | lap | 100% InN | 3.0 | 3280 |
| 178 | nitride | | | 15 | specular surface 3 | 100% InN | 3.0 | 777 |
| 179 | | | | 4.4 | specular surface 4 | 100% InN | 3.0 | 239 |
| 180 | Aluminum | Example 1 | 17˜19 | 920 | as-fired | 100% AlN | 3.0 | 2210 |
| 181 | oxide | | | 11 | specular surface 5 | 100% AlN | 3.0 | 405 |
| 182 | | | | 1.9 | specular surface 6 | 100% AlN | 3.0 | 206 |
| 183 | Zinc oxide | Example 1 | 22˜24 | 740 | as-fired | 100% GaN | 3.0 | 2380 |
| 184 | | | | 630 | lap | 100% GaN | 3.0 | 2020 |
| 185 | | | | 29 | specular surface 7 | 100% GaN | 3.0 | 834 |
| 186 | Beryllium | Example 1 | 27˜29 | 340 | as-fired | 100% AlN | 3.0 | 2284 |
| 187 | oxide | | | 20 | specular surface 8 | 100% AlN | 3.0 | 770 |
| 188 | | | | 9.4 | specular surface 9 | 100% AlN | 3.0 | 282 |

TABLE 9

| | | | | | Characteristics of the thin film formed | | |
|---|---|---|---|---|---|---|---|
| | Characteristics of the sintered compact substrate | | | | on various sintered compacts | | |
| | | Used substrates | | | | | Half width of |
| | | Example | | Degree of | | Thickness | the (002) X ray |
| | | which produced | | surface | Composition | of | diffraction |
| Experiment | Main | Example | Experiment | smoothness | of | the thin film | rocking curve |
| No. | ingredient | No. | No. | Ra (nm) | the thin film | (μm) | (second) |
| 189 | Aluminum | Example 1 | 1˜5 | 34 | 50 mol % GaN + 50 mol % | 1.0 | 214 |
| | nitride | | | | InN | | |
| 190 | | | | | 50 mol % GaN + 50 mol % | 4.0 | 175 |
| | | | | | InN | | |
| 191 | | | | | 50 mol % GaN + 50 mol % | 15.0 | 146 |
| | | | | | InN | | |
| 192 | | Example 2 | 34 | 25 | 100% AlN | 15.0 | 141 |
| 193 | | | | | 100% AlN | 200 | 126 |
| 194 | | Example 2 | 46 | 28 | 100% AlN | 15.0 | 140 |
| 195 | | | | | 100% AlN | 100 | 122 |
| 196 | | Example 2 | 62 | 22 | 100% AlN | 15.0 | 132 |
| 197 | | | | | 100% AlN | 100 | 127 |
| 198 | | Example 2 | 64 | 17 | 100% AlN | 7.0 | 136 |
| 199 | | | | | 100% AlN | 15.0 | 143 |
| 200 | | | | | 100% AlN | 100 | 125 |
| 201 | | Example 4 | 86˜92 | 24 | 100% AlN | 15.0 | 137 |
| 202 | | | | | 100% AlN | 60.0 | 124 |
| 203 | | | | | 100% AlN | 200 | 122 |
| 204 | | Example 4 | 93˜99 | 29 | 100% InN | 1.0 | 186 |
| 205 | | | | | 100% InN | 5.0 | 165 |
| 206 | | | | | 100% InN | 15.0 | 139 |
| 207 | | Example 4 | 100˜102 | 26 | 50 mol % GaN + 50 mol % | 6.0 | 187 |
| | | | | | AlN | | |
| 208 | | | | | 50 mol % GaN + 50 mol % | 15.0 | 135 |
| | | | | | AlN | | |
| 209 | | | | | 50 mol % GaN + 50 mol % | 100 | 120 |
| | | | | | AlN | | |
| 210 | | Example 6 | 103 | 16 | 100% AlN | 100 | 124 |
| 211 | | | | | 100% AlN | 500 | 114 |
| 212 | | Example 6 | 105 | 27 | 100% AlN | 15.0 | 122 |
| 213 | | | | | 100% AlN | 100 | 113 |
| 214 | | Example 6 | 107 | 23 | 100% AlN | 15.0 | 140 |
| 215 | | | | | 100% AlN | 100 | 121 |
| 216 | | Example 6 | 108 | 22 | 100% AlN | 15.0 | 131 |
| 217 | | | | | 100% AlN | 1000 | 109 |
| 218 | | Example 6 | 109 | 27 | 100% GaN | 1.0 | 184 |
| 219 | | | | | 100% GaN | 6.0 | 156 |
| 220 | | | | | 100% GaN | 15.0 | 135 |
| 221 | | Example 6 | 110 | 22 | 100% AlN | 15.0 | 126 |
| 222 | | | | | 100% AlN | 60.0 | 119 |
| 223 | Silicon | Example 1 | 11˜13 | 6.8 | 100% AlN | 0.5 | 260 |
| 224 | carbide | | | | 100% AlN | 15.0 | 202 |
| 225 | Silicon | Example 1 | 14˜16 | 15 | 100% InN | 0.5 | 669 |
| 226 | nitride | | | | 100% InN | 15.0 | 216 |
| 227 | Aluminum | Example 1 | 17˜19 | 11 | 100% AlN | 1.0 | 391 |
| 228 | oxide | | | | 100% AlN | 6.0 | 217 |
| 229 | | | | | 100% AlN | 15.0 | 216 |
| 230 | Zinc oxide | Example 1 | 22˜24 | 8.8 | 100% GaN | 0.5 | 289 |
| 231 | | | | | 100% GaN | 15.0 | 220 |
| 232 | Beryllium | Example 1 | 27˜29 | 9.4 | 100% AlN | 1.0 | 276 |
| 233 | oxide | | | | 100% AlN | 6.0 | 219 |
| 234 | | | | | 100% AlN | 15.0 | 214 |

TABLE 10

| | Characteristics of the sintered compact substrate | | | | Characteristics of the thin film formed on various sintered compacts | | | |
|---|---|---|---|---|---|---|---|---|
| | | Used substrates | | | | | | Half width of |
| | | | | Degree of | Formation | | Thickness | the (002) X ray |
| | | Example which produced | | surface | position | Composition | of the | diffraction |
| Experiment | Main | Example | Experiment | smoothness | of | of | thin film | rocking curve |
| No. | ingredient | No. | No. | Ra (nm) | the thin film | the thin film | (μm) | (second) |
| 235 | Aluminum | Example 1 | 1˜5 | 34 | The 1st layer | 100% GaN | 1.0 | 181 |
| | nitride | | | | The 2nd layer | 50 mol % GaN + 50 mol % | 1.0 | 119 |
| | | | | | | InN | | |
| 236 | | Example 2 | 34 | 25 | The 1st layer | 100% AlN | 6.0 | 159 |
| | | | | | The 2nd layer | 100% GaN | 2.0 | 137 |
| 237 | | Example 2 | 46 | 28 | The 1st layer | 100% AlN | 15.0 | 140 |
| | | | | | The 2nd layer | 49.94 mol % GaN + 49.94 mol % | 3.0 | 102 |
| | | | | | | AlN + 0.12 mol % | | |
| | | | | | | Si | | |
| 238 | | Example 2 | 62 | 22 | The 1st layer | 100% AlN | 15.0 | 132 |
| | | | | | The 2nd layer | 99.94 mol % AlN + 0.06 mol % | 6.0 | 123 |
| | | | | | | Si | | |
| 239 | | Example 2 | 64 | 17 | The 1st layer | 100% AlN | 7.0 | 136 |
| | | | | | The 2nd layer | 100% AlN | 7.0 | 107 |
| | | | | | The 3rd layer | 100% GaN | 1.0 | 105 |
| 240 | | Example 4 | 93˜99 | 29 | The 1st layer | 100% AlN | 1.0 | 186 |
| | | | | | The 2nd layer | 99.9 mol % GaN + 0.1 mol % | 3.0 | 149 |
| | | | | | | Si | | |
| | | | | | The 3rd layer | 99.9 mol % GaN + 0 mol [symbol] % | 3.0 | 124 |
| | | | | | | Mg | | |
| 241 | | Example 4 | 100˜102 | 26 | The 1st layer | 100% GaN | 6.0 | 140 |
| | | | | | The 2nd layer | 99.9 mol % GaN + 0.1 mol % | 1.0 | 127 |
| | | | | | | Be | | |
| | | | | | The 3rd layer | 70 mol % GaN + 30 mol % | 1.0 | 116 |
| | | | | | | InN | | |
| 242 *) | | Example 6 | 103 | 16 | The 1st layer | 100% AlN | 100 | 124 |
| | | | | | The 2nd layer | 99.9 mol % GaN + 0.1 mol % | 3.0 | 121 |
| | | | | | | Zn | | |
| 243 | | Example 6 | 105 | 27 | The 1st layer | 100% AlN | 15.0 | 122 |
| | | | | | The 2nd layer | 69.9 mol % GaN + 30 mol % | 3.0 | 107 |
| | | | | | | InN + 0.1 mol % | | |
| | | | | | | Mg | | |
| 244 *) | | Example 6 | 107 | 23 | The 1st layer | 100% AlN | 15.0 | 140 |
| | | | | | The 2nd layer | 79.9 mol % GaN + 20 mol % | 60 | 117 |
| | | | | | | AlN + 0.1 mol % | | |
| | | | | | | Mg | | |
| 245 *) | | Example 6 | 108 | 22 | The 1st layer | 100% AlN | 200 | 114 |
| | | | | | The 2nd layer | 100% GaN | 10.0 | 110 |
| 246 | | Example 6 | 109 | 27 | The 1st layer | 99.96 mol % AlN + 0.04 mol % | 15.0 | 132 |
| | | | | | | Si | | |
| | | | | | The 2nd layer | 70 mol % GaN + 30 mol % | 6.0 | 123 |
| | | | | | | InN | | |
| | | | | | The 3rd layer | 100% InN | 3.0 | 107 |
| 247 | Silicon | Example 1 | 11˜13 | 6.8 | The 1st layer | 100% AlN | 0.5 | 272 |
| | carbide | | | | The 2nd layer | 50 mol % GaN + 50 mol % | 1.0 | 237 |
| | | | | | | AlN | | |
| 248 | Silicon | Example 1 | 14˜16 | 15 | The 1st layer | 100% AlN | 0.5 | 724 |
| | nitride | | | | The 2nd layer | 100% GaN | 1.0 | 205 |
| 249 | Aluminum | Example 1 | 17˜19 | 11 | The 1st layer | 100% AlN | 1.0 | 391 |
| | oxide | | | | The 2nd layer | 99.97 mol % AlN + 0.03 mol % | 6.0 | 204 |
| | | | | | | Si | | |
| | | | | | The 3rd layer | 50 mol % Ga + 50 mol % | 15.0 | 190 |
| | | | | | | AlN | | |
| 250 | Zinc oxide | Example 1 | 2.2˜2.4 | 8.8 | The 1st layer | 100% AlN | 0.5 | 289 |
| | | | | | The 2nd layer | 50 mol % GaN + 50 mol % | 1.0 | 201 |
| | | | | | | AlN | | |
| 251 | Beryllium | Example 1 | 27˜29 | 9.4 | The 1st layer | 100% AlN | 1.0 | 276 |
| | oxide | | | | The 2nd layer | 99.99 mol % AlN + 0.01 mol % | 6.0 | 210 |
| | | | | | | Si | | |
| | | | | | The 3rd layer | 50 mol % GaN + 50 mol % | 15.0 | 177 |
| | | | | | | AlN | | |

*) using the Chloride VPE method

TABLE 11
Characteristics of the sintered compact substrate comprising an aluminum nitride as the main ingredients

| | The powder compacts or the | | | | Characteristics of the sintered compact comprising | | | | | |
|---|---|---|---|---|---|---|---|---|---|---|
| | sintered compacts fired | | | | an aluminum nitride as the main ingredients | | | | | |
| | | | Content | | Additive | | | | Average | |
| | Kind of the raw | Additive | of the | | contents, such as | | | Quantity | size | |
| | material powder, | agents, | additive | | sintering aids | | Oxygen | of | of the | |
| | kind of | such as | agent | Firing | Additive | Content | content | the AlN | the AlN | Optical |
| Experiment | the sintered | sintering | (weight | conditions | agent | (ppm) | (weight | crystal phase | particle | transmissivity |
| No. | compact fired | aids | %) *1) | *2) | element | *3) | %) | (%) | (μm) | (%) |
| 252 | Method | None | — | (1) | — | — | 1.2 | 96.2 | 3.6 | 56 |
| 253 | of | None | — | (8) | — | — | 1.3 | 97.1 | 38 | 64 |
| 254 | oxide reduction | Al₂O₃ | 2.0 | (1) | — | — | 1.5 | 96.7 | 3.7 | 18 |
| 255 | | Al₂O₃ | 2.0 | (11) | — | — | 1.4 | 97.4 | 44 | 52 |
| 256 | | CaCO₃ | 0.5 | (3) | Ca | 800 | 0.4 | 98.5 | 7.5 | 46 |
| 257 | | CaCO₃ | 0.5 | (6) | Ca | 320 | 0.17 | 99.1 | 28 | 66 |
| 258 | | CaCO₃ | 0.5 | (7) | Ca | 75 | 0.09 | single phase | 32 | 77 |
| 259 | | CaCO₃ | 0.5 | (10) | Ca | 45 | 0.06 | single phase | 49 | 81 |
| 260 | | Y₂O₃ | 1.0 | (3) | Y | 1900 | 0.4 | 96.9 | 8.8 | 53 |
| 261 | | Y₂O₃ | 1.0 | (7) | Y | 20 | 0.07 | single phase | 31 | 74 |
| 262 | | Y₂O₃ | 1.0 | (10) | Y | <0.5 | 0.03 | single phase | 46 | 82 |
| 263 | | Y₂O₃ | 5.0 | (3) | Y | 4600 | 0.7 | 96.4 | 7.7 | 37 |
| 264 | | Y₂O₃ | 5.0 | (7) | Y | 85 | 0.04 | 99.2 | 35 | 76 |
| 265 | | Y₂O₃ | 5.0 | (10) | Y | 10 | 0.02 | single phase | 47 | 86 |
| 266 | | Y₂O₃ | 5.0 | (2) | Y | 4200 | 0.8 | 97.2 | 6.4 | 47 |
| | | CaCO₃ | 0.5 | | Ca | 200 | | | | |
| 267 | | Y₂O₃ | 5.0 | (5) | Y | 850 | 0.09 | 98.6 | 17 | 75 |
| | | CaCO₃ | 0.5 | | Ca | 65 | | | | |
| 268 | | Y₂O₃ | 5.0 | (6) | Y | 10 | 0.04 | single phase | 29 | 81 |
| | | CaCO₃ | 0.5 | | Ca | 6 | | | | |
| 269 | | Y₂O₃ | 5.0 | (9) | Y | <0.5 | 0.02 | single phase | 37 | 86 |
| | | CaCO₃ | 0.5 | | Ca | <0.5 | | | | |
| 270 | | Yb₂O₃ | 5.0 | (6) | Yb | 25 | 0.03 | single phase | 27 | 82 |
| | | CaCO₃ | 0.5 | | Ca | 5 | | | | |
| 271 | | Er₂O₃ | 10.0 | (7) | Er | 170 | 0.06 | 99.2 | 30 | 68 |
| 272 | | Si | 0.5 | (4) | Si | 1500 | 0.7 | 95.5 | 11 | 42 |
| 273 | | MoO₃ | 1.0 | (4) | Mo | 2100 | 0.8 | 95.4 | 12 | 34 |
| 274 | | carbon | 1.0 | (4) | C | 160 | 0.07 | 98.1 | 10 | 27 |
| 275 | | Fe | 0.5 | (4) | Fe | 510 | 0.3 | 96.1 | 13 | 44 |
| 276 | | Ni | 0.5 | (4) | Ni | 740 | 0.4 | 95.9 | 9.5 | 40 |
| 277 | Direct nitriding | Y₂O₃ | 1.0 | (3) | Y | 1700 | 0.6 | 96.4 | 9.4 | 53 |
| 278 | method | Y₂O₃ | 1.0 | (7) | Y | 10 | 0.04 | single phase | 36 | 81 |
| 279 | of | Y₂O₃ | 1.0 | (10) | Y | <0.5 | 0.03 | single phase | 48 | 85 |
| 280 | metal aluminum | Y₂O₃ | 5.0 | (2) | Y | 4200 | 0.7 | 96.7 | 7.2 | 51 |
| | | CaCO₃ | 0.5 | | Ca | 500 | | | | |
| 281 | | Y₂O₃ | 5.0 | (6) | Y | 6 | 0.03 | single phase | 28 | 83 |
| | | CaCO₃ | 0.5 | | Ca | 6 | | | | |
| 282 | | Y₂O₃ | 5.0 | (9) | Y | <0.5 | 0.02 | single phase | 40 | 87 |
| | | CaCO₃ | 0.5 | | Ca | <0.5 | | | | |
| 283 | Fired | Y₂O₃ | 1.0 | (5) | Y | 920 | 0.08 | 99.1 | 20 | 77 |
| 284 | sintered | Y₂O₃ | 1.0 | (10) | Y | <0.5 | 0.02 | single phase | 46 | 88 |
| 285 | compact *4) | Y₂O₃ | 5.0 | (7) | Y | 24 | 0.03 | single phase | 34 | 84 |
| 286 | | Y₂O₃ | 5.0 | (6) | Y | 3 | 0.02 | single phase | 30 | 87 |
| | | CaCO₃ | 0.5 | | Ca | 2 | | | | |

*1) Content of the sintering aid is what carried out oxide conversion.
*2) Firing conditions:
(1) 1800° C. × 2 hours
(2) 1800° C. × 12 hours
(3) 1800° C. × 24 hours
(4) 1950° C. × 4 hours
(5) 1950° C. × 12 hours
(6) 2100° C. × 4 hours
(7) 2100° C. × 12 hours
(8) 2100° C. × 24 hours
(9) 2200° C. × 4 hours
(10) 2200° C. × 8 hours
(11) 2200° C. × 12 hours
*3) Content of the sintering aid in a sintered compact is shown by the weight rate of part par million. And, the content is a value by element conversion.
*4) Composition of the fired sintered compact is a blend composition at the time of a powder compact, and amount of the sintering aid is what carried out oxide conversion.

TABLE 12

| | Characteristics of the single crystal thin film formed on | | |
|---|---|---|---|
| | the sintered compact comprising an aluminum nitride | | |
| | as the main ingredients | | |
| | | | Half width of the |
| Experi- | Composition | Thin film | (002) X ray diffraction |
| ment | of | thickness | rocking curve |
| No. | the thin film | (μm) | (second) |
| 252 | 100% GaN | 0.25 | 192 |
| 253 | 100% GaN | 0.25 | 117 |
| 254 | 100% GaN | 0.25 | 187 |
| 255 | 100% GaN | 0.25 | 122 |
| 256 | 100% GaN | 0.25 | 145 |
| 257 | 100% GaN | 0.25 | 96 |
| 258 | 100% GaN | 0.25 | 97 |
| 259 | 100% GaN | 0.25 | 91 |
| 260 | 100% InN | 0.25 | 139 |
| 261 | 100% GaN | 0.25 | 98 |
| 262 | 100% GaN | 0.25 | 94 |
| 263 | 100% GaN | 0.25 | 161 |
| 264 | 100% GaN | 0.25 | 90 |
| 265 | 100% GaN | 0.25 | 93 |
| 266 | 50 mol % GaN + 50 mol % | 0.25 | 144 |
| | InN | | |
| 267 | 100% GaN | 0.25 | 124 |
| 268 | 50 mol % GaN + 50 mol % | 6.0 | 95 |
| | AlN | | |
| 269 | 100% GaN | 0.25 | 92 |
| 270 | 100% GaN | 0.25 | 94 |
| 271 | 100% GaN | 0.25 | 98 |
| 272 | 100% GaN | 0.25 | 147 |
| 273 | 100% GaN | 0.25 | 137 |
| 274 | 100% GaN | 0.25 | 132 |
| 275 | 100% GaN | 0.25 | 143 |
| 276 | 100% GaN | 0.25 | 140 |
| 277 | 100% GaN | 0.25 | 135 |
| 278 | 100% GaN | 0.25 | 93 |
| 279 | 100% GaN | 0.25 | 90 |
| 280 | 100% GaN + 50 mol % | 0.25 | 126 |
| | InN | | |
| 281 | 100% GaN | 0.25 | 96 |
| 282 | 100% GaN | 0.25 | 89 |
| 283 | 100% GaN | 0.25 | 111 |
| 284 | 100% GaN | 0.25 | 91 |
| 285 | 100% GaN | 0.25 | 95 |
| 286 | 100% GaN | 0.25 | 89 |

TABLE 13

| | | | | | The constitution of the thin film formed on various | | | | |
|---|---|---|---|---|---|---|---|---|---|
| | | | | | sintered compacts and the crystallinity of the thin film | | | | |
| | | | | | | | | | Half width |
| | | | | | | | | | of the (002) |
| | | | | | | | | | X ray |
| | Characteristics of the | | | | | | | | diffraction |
| | sintered compact substrate | | | | | | | | rocking curve |
| | | Used substrates | | | | | | | of the single |
| | | | | Degree | | | | | crystal thin |
| | | Example which | | of | Formation | | | Thickness | film and |
| | | produced | | surface | position | Composition | Crystallized | of the | the orientated |
| Experiment | Main | Example | Experiment | smoothness | of | of | state of | thin film | polycrystal thin |
| No. | ingredient | No. | No. | Ra (nm) | the thin film | the thin film | the thin film | (μm) | film (second) |
| 287 | Aluminum | Example 2 | 46 | 29 | Substrate side | 100% GaN | Amorphous | 0.25 | — |
| | nitride | | | | Surface layer | 50 mol % GaN + | Single crystal | 0.25 | 94 |
| | | | | | | 50 mol % InN | | | |
| 288 | | Example 2 | 46 | 29 | Substrate side | 100% AlN | Amorphous | 2.5 | — |
| | | | | | Surface layer | 100% GaN | Single crystal | 0.25 | 97 |
| 289 | | Example 2 | 49 | 26 | Substrate side | 100% AlN | Amorphous | 2.5 | — |
| | | | | | Surface layer | 49.94 mol % GaN + | Single crystal | 2.5 | 93 |
| | | | | | | 49.94 mol % AlN + | | | |
| | | | | | | 0.12 mol % Si | | | |
| 290 | | Example 2 | 49 | 26 | Substrate side | 100% AlN | Amorphous | 2.5 | — |
| | | | | | Surface layer | 99.94 mol % AlN + | Single crystal | 2.5 | 92 |
| | | | | | | 0.06 mol % Si | | | |
| 291 | | Example 6 | 110 | 22 | Substrate side | 100% AlN | Orientated | 2.5 | 4620 |
| | | | | | | | polycrystal | | |
| | | | | | Intermediate | 100% AlN | Single crystal | 2.5 | 96 |
| | | | | | layer | | | | |
| | | | | | Surface layer | 100% GaN | Single crystal | 0.25 | 91 |
| 292 | | Example 6 | 110 | 22 | Substrate side | 100% AlN | Amorphous | 2.5 | — |
| | | | | | Intermediate | 99.9 mol % GaN + | Single crystal | 0.25 | 97 |
| | | | | | layer | 0.1 mol % Si | | | |
| | | | | | Surface layer | 99.9 mol % GaN + | Single crystal | 2.5 | 89 |
| | | | | | | 0.1 mol % Mg | | | |
| 293 | | Example | 267 | 30 | Substrate side | 100% GaN | Amorphous | 0.25 | — |
| | | 11 | | | Intermediate | 99.9 mol % GaN + | Orientated | 2.5 | 4540 |
| | | | | | layer | 0.1 mol % Be | polycrystal | | |
| | | | | | Surface layer | 70 mol % GaN + | Single crystal | 2.5 | 90 |
| | | | | | | 30 mol % InN | | | |
| 294 | | Example | 269 | 30 | Substrate side | 100% AlN | Amorphous | 2.5 | — |
| | | 11 | | | Surface layer | 99.9 mol % GaN + | Single crystal | 0.25 | 82 |
| | | | | | | 0.1 mol % Mg | | | |
| 295 | | Example | 283 | 30 | Substrate side | 100% AlN | Single crystal | 2.5 | 127 |
| | | 11 | | | Surface layer | 69.9 mol % GaN + | Single crystal | 0.25 | 87 |
| | | | | | | 30 mol % InN + | | | |
| | | | | | | 0.1 mol % Mg | | | |
| 296 | | Example | 283 | 30 | Substrate side | 100% AlN | Polycrystal | 2.5 | — |
| | | 11 | | | Surface layer | 79.9 mol % GaN + | Single crystal | 2.5 | 89 |
| | | | | | | 20 mol % AlN + | | | |
| | | | | | | 0.1 mol % Mg | | | |
| 297 | Silicon | Example 1 | 11˜13 | 6.8 | Substrate side | 100% AlN | Amorphous | 2.5 | — |
| | carbide | | | | Surface layer | 50 mol % GaN + | Single crystal | 2.5 | 189 |
| | | | | | | 50 mol % AlN | | | |
| 298 | Silicon | Example 1 | 14˜16 | 15 | Substrate side | 100% AlN | Amorphous | 2.5 | — |
| | nitride | | | | Surface layer | 100% GaN | Single crystal | 0.25 | 192 |
| 299 | Aluminum | Example 1 | 17˜19 | 11 | Substrate side | 100% AlN | Amorphous | 2.5 | — |
| | oxide | | | | Intermediate | 99.97 mol % AlN + | Orientated | 2.5 | 10820 |
| | | | | | layer | 0.03 mol % Si | polycrystal | | |
| | | | | | Surface layer | 50 mol % Ga + | Single crystal | 2.5 | 165 |
| | | | | | | 50 [symbol] % AlN | | | |
| 300 | Zinc oxide | Example 1 | 22˜24 | 8.8 | Substrate side | 100% AlN | Amorphous | 2.5 | — |
| | | | | | Surface layer | 50 mol % GaN + | Single crystal | 2.5 | 174 |
| | | | | | | 50 mol % AlN | | | |
| 301 | Beryllium | Example 1 | 27˜29 | 9.4 | Substrate side | 100% AlN | Amorphous | 2.5 | — |
| | oxide | | | | Intermediate | 99.99 mol % AlN + | Orientated | 2.5 | 9890 |
| | | | | | layer | 0.01 mol % Si | polycrystal | | |
| | | | | | Surface layer | 50 mol % GaN + | Single crystal | 2.5 | 146 |
| | | | | | | 50 mol % AlN | | | |

TABLE 14

| | | | | | Electric | |
|---|---|---|---|---|---|---|
| | AlN content | | | | resistivity | |
| | in | | | | of the | Half width of |
| | the tungsten | | Firing | Diameter | conduction via | the (002) |
| | paste for | | conditions | of the | after firing | X-ray |
| | a conduction | Sintering | of the | through | in room | diffraction |
| Experiment | via | aids in the | green | hole | temperature × 10⁻⁶ | rocking curve |
| No. | (weight %) | green sheet | sheet | (μm) | (Ω · cm) | (second) |
| 302 | 0.0 | Y₂O₃ | 1800° C. × 2 | 25 | 7.0 | 191 |
| 303 | 1.0 | 5 weight % | hours | 25 | 7.5 | 192 |
| 304 | 5.0 | | | 25 | 9.1 | 175 |
| 305 | 10.0 | | | 25 | 37 | 146 |
| 306 | 20.0 | | | 25 | 69 | 131 |
| 307 | 30.0 | | | 25 | 132 | 122 |
| 308 | 0.0 | Y₂O₃ | 2200° C. × 4 | 25 | 6.8 | 95 |
| 309 | 0.1 | 5 weight % + CaO | hours | 25 | 6.9 | 92 |
| 310 | 1.0 | 0.5 | | 25 | 7.4 | 92 |
| 311 | 5.0 | weight % | | 25 | 9.7 | 93 |
| 312 | 10.0 | | | 25 | 43 | 87 |
| 313 | 1.0 | | 1800° C. × 2 | 50 | 8.0 | 184 |
| 314 | 5.0 | | hours | 50 | 9.0 | 166 |
| 315 | 0.1 | Y₂O₃ | 2200° C. × 4 | 50 | 6.9 | 97 |
| 316 | 1.0 | 5 weight % | hours | 50 | 6.9 | 94 |
| 317 | 5.0 | | | 50 | 8.2 | 91 |
| 318 | 10.0 | | | 50 | 32 | 89 |

TABLE 15

| | | | Characteristics of the thin film formed on the sintered compact | | | | |
|---|---|---|---|---|---|---|---|
| | | | comprising an aluminum nitride as the main ingredients | | | | |
| | | | Composition of the | | | Electric | Half width of the |
| | | | single crystal thin film | | | resistivity | (002) X ray |
| | | | Main | | | of the single | diffraction |
| | | | ingredient: | Doping agent | | crystal thin | rocking curve of |
| | Used substrates | | Composition | | Amount of | film in room | the single crystal |
| Experiment | | Experiment | of AlₓGa₁₋ₓN | | addition | temperature | thin film |
| No. | Example | No. | (x) | Element | (mol %) | (Ω · cm) | (second) |
| 319 | Example 2 | 49 | 0.1 | Mg | 0.1 | 0.079 | 141 |
| 320 | Example 3 | 73 | 0.1 | Mg | 2.0 | 0.92 | 176 |
| 321 | Example 3 | 73 | 0.9 | Si | 0.02 | 56 | 163 |
| 322 | Example 3 | 73 | 0.6 | Mg | 0.01 | 5.4 | 171 |
| | | | | Si | 0.01 | | |
| 323 | Example 3 | 75 | 0.2 | Mg | 0.3 | 1.0 | 154 |
| 324 | Example 3 | 75 | 0.7 | Si | 0.03 | 8.5 | 144 |
| 325 | Example 3 | 75 | 0.1 | Mg | 0.08 | 0.009 | 160 |
| | | | | Si | 0.1 | | |
| 326 | Example 3 | 80 | 0.6 | Mg | 0.2 | 77 | 177 |
| 327 | Example 3 | 80 | 0.1 | Si | 7.0 | 0.06 | 181 |
| 328 | Example 3 | 80 | 0.0 | Mg | 0.1 | 0.007 | 188 |
| | | | | Si | 0.5 | | |
| 329 | Example 3 | 82 | 0.3 | Mg | 0.2 | 3.1 | 186 |
| 330 | Example 3 | 82 | 0.8 | Si | 0.01 | 49 | 179 |
| 331 | Example 3 | 82 | 0.5 | Mg | 0.5 | 2.6 | 179 |
| | | | | Si | 0.1 | | |
| 332 | Example 6 | 110 | 0.4 | Mg | 0.1 | 5.1 | 117 |
| 333 | Example 11 | 284 | 0.0 | Si | 0.0005 | 0.014 | 86 |
| 334 | Example 14 | 305 | 0.0 | Mg | 0.1 | 0.47 | 166 |
| 335 | Example 14 | 305 | 0.2 | Si | 0.05 | 0.07 | 164 |
| 326 | Example 14 | 305 | 0.4 | Mg | 0.1 | 2.4 | 157 |
| | | | | Si | 0.05 | | |
| 337 | Example 14 | 311 | 0.6 | Mg | 0.12 | 33 | 90 |
| 338 | Example 14 | 311 | 1.0 | Si | 0.02 | 85 | 88 |
| 339 | Example 14 | 311 | 0.8 | Mg | 0.02 | 29 | 89 |
| | | | | Si | 0.02 | | |
| 340 | Example 14 | 317 | 0.1 | Mg | 0.5 | 0.90 | 88 |
| 341 | Example 14 | 317 | 1.0 | Si | 0.005 | 194 | 85 |
| 342 | Example 14 | 317 | 0.3 | Mg | 0.4 | 2.0 | 87 |
| | | | | Si | 0.05 | | |

TABLE 16

| | | | Characteristics of the various crystallized state thin films formed on the sintered compact | | | | |
|---|---|---|---|---|---|---|---|
| | | | comprising an aluminum nitride as the main ingredients | | | | |
| | | | | | | | Half width of the |
| | Sintered compact | | | | | Electric | (002) X ray |
| | substrates | | | | | resistivity of | diffraction |
| | Used | | | | | the thin film | rocking curve of |
| | substrates | | Constitution | Composition | Crystallized | in room | the single crystal |
| Experiment | Example | Experiment | of | of | state of | temperature | thin film |
| No. | No. | No. | the thin film | the thin film | the thin film | (Ω · cm) | (second) |
| 343 | Example 2 | 49 | Single layer | 99.94 [symbol] % InN + 0.06 [symbol] % | Amorphous | 0.006 | — |
| | | | | Si | | | |
| 344 | Example 2 | 49 | Single layer | 99.94 [symbol] % InN + 0.06 [symbol] % | Orientated | 0.004 | — |
| | | | | Si | polycrystal | | |
| 345 | Example 2 | 49 | Single layer | 99.94 [symbol] % InN + 0.06 [symbol] % | Single | 0.003 | 137 |
| | | | | Si | crystal | | |
| 346 | Example 3 | 73 | Single layer | 99.98 [symbol] % AlN + 0.02 [symbol] % | Amorphous | 126 | — |
| | | | | Si | | | |
| 347 | Example 3 | 73 | Substrate side | 100% GaN | Amorphous | 0.12 | — |
| | | | Surface layer | 79.90 [symbol] % GaN + 19.98 [symbol] % | Single | 0.36 | 85 |
| | | | | InN + 0.12 [symbol] % | crystal | | |
| | | | | Mg | | | |
| 348 | Example 3 | 75 | Single layer | 19.98 [symbol] % GaN + 79.90 [symbol] % | Amorphous | 0.16 | — |
| | | | | InN + 0.12 [symbol] % | | | |
| | | | | Mg | | | |
| 349 | Example 3 | 80 | Single layer | 49.94 [symbol] % GaN + 49.94 [symbol] % | Amorphous | 0.74 | — |
| | | | | AlN + 0.12 [symbol] % | | | |
| | | | | Si | | | |
| 350 | Example 3 | 80 | Single layer | 100% InN | Amorphous | 0.022 | — |
| 351 | Example 3 | 82 | Single layer | 100% InN | Orientated | 0.016 | — |
| | | | | | polycrystal | | |
| 352 | Example | 304 | Single layer | 49.94 [symbol] % GaN + 49.94 [symbol] % | Amorphous | 3.2 | — |
| | 14 | | | AlN + 0.12 [symbol] % | | | |
| | | | | Mg | | | |
| 353 | Example | 304 | Single layer | 100% InN | Single | 0.014 | 169 |
| | 14 | | | | crystal | | |
| 354 | Example | 304 | Single layer | 100% GaN | Single | 0.048 | 170 |
| | 14 | | | | crystal | | |
| 355 | Example | 311 | Single layer | 99.98 [symbol] % AlN + 0.02 [symbol] % | Orientated | 94 | — |
| | 14 | | | Si | polycrystal | | |
| 356 | Example | 317 | Substrate side | 100% GaN | Polycrystal | 0.09 | — |
| | 14 | | Surface layer | 99.98 [symbol] % AlN + 0.02 [symbol] % | Single | 77 | 81 |
| | | | | Si | crystal | | |

TABLE 17

| | | | | | Characteristics of the thin film which comprises as the main | | | | |
|---|---|---|---|---|---|---|---|---|---|
| | | | | | ingredients a gallium nitride, an indium nitride, and an aluminum nitride | | | | |
| | | | | | and which was formed on the thin film conductivity material | | | | |
| | | | | | | Electric | | Half width | Junction strength |
| | | Characteristics of the thin | | | | resistivity | | of the | with thin film |
| | Used | film conductivity material | | | | of | | (002) X ray | conductivity |
| Ex- | substrates | Constitution | | | | the thin film | | diffraction | material: |
| peri- | Experi- | of thin film | Thick- | | | (Ω · cm) | Crystallized | rocking | perpendicular |
| ment | ment | conductivity | ness | Reflec- | | (room | state of | curve | tension |
| No. | No. | material | (μm) | tance | Composition | temperature) | the thin film | (second) | (Kg/mm²) |
| 357 | 49 | Ti | 0.1 | | 100 [symbol] % GaN | 0.052 | Single crystal | 144 | 3.1 |
| 358 | 73 | Ti | 0.2 | | 100 [symbol] % AlN | — | Single crystal | 172 | 3.2 |
| 359 | 73 | Ti | 0.1 | | 99.94 [symbol] % GaN + 0.06 [symbol] % | 0.009 | Single crystal | 160 | 3.0 |
| | | | | | Si | | | | |
| 360 | 75 | Cr | 0.2 | | 99.94 [symbol] % InN + 0.06 [symbol] % | 0.007 | Amorphous | — | 3.1 |
| | | | | | Si | | | | |
| 361 | 75 | Ni | 2.0 | 64 | 19.98 [symbol] % InN + 79.9 [symbol] % | 0.34 | Single crystal | 150 | 2.8 |
| | | | | | GaN + 0.12 [symbol] % | | | | |
| | | | | | Mg | | | | |
| 362 | 80 | Mo | 0.6 | 53 | 19.98 [symbol] % GaN + 79.9 [symbol] % | 0.085 | Amorphous | — | 3.0 |
| | | | | | InN + 0.12 [symbol] % | | | | |
| | | | | | Mg | | | | |
| 363 | 80 | W | 1.0 | 52 | 49.94 [symbol] % GaN + 49.94 [symbol] | 0.57 | Amorphous | — | 3.3 |
| | | | | | AlN + 0.12 [symbol] % | | | | |
| | | | | | Si | | | | |
| 364 | 82 | W | 0.5 | 54 | 100 [symbol] % InN | 0.020 | Amorphous | — | 2.9 |
| 365 | 82 | Pt | 0.5 | 77 | 50 [symbol] % GaN + 50 [symbol] % | — | Single crystal | 179 | 2.7 |
| | | | | | AlN | | | | |
| 366 | 110 | Al | 3.0 | 92 | 99.98 [symbol] % AlN + 0.02 [symbol] % | 116 | Amorphous | — | 2.6 |
| | | | | | Si | | | | |
| 367 | 284 | Ni—Cr | 0.8 | | 100 [symbol] % AlN | — | Amorphous | — | 2.8 |
| 368 | 305 | Ta | 0.6 | | 49.94 [symbol] % GaN + 49.94 [symbol] | 0.42 | Single crystal | 164 | 3.1 |
| | | | | | AlN + 0.12 [symbol] % | | | | |
| | | | | | Si | | | | |
| 369 | 305 | Ta₂N | 0.5 | | 100 [symbol] % GaN | 0.060 | Amorphous | — | 2.9 |
| 370 | 305 | TiN | 0.5 | | 100 [symbol] % InN | 0.014 | Single crystal | 166 | 2.9 |
| 371 | 311 | Ti (adhesion) | 0.1 | 91 | 49.94 [symbol] % GaN + 49.94 [symbol] | 3.2 | Single crystal | 90 | 2.4 |
| | | Pt (barrier) | 0.2 | | AlN + 0.12 [symbol] % | | | | |
| | | Au (low | 0.6 | | Mg | | | | |
| | | resistance) | | | | | | | |
| 372 | 311 | Ti (adhesion) | 0.1 | 90 | 69.86 [symbol] % GaN + 29.94 [symbol] | 1.6 | Orientated | 4790 | 2.8 |
| | | W (barrier) | 0.5 | | AlN + 0.20 [symbol] % | | polycrystal | | |
| | | Au (low | 0.8 | | Mg | | | | |
| | | resistance) | | | | | | | |
| 373 | 317 | W: 70 wt % | 0.5 | 74 | 69.86 [symbol] % GaN + 29.94 [symbol] | 0.56 | Single crystal | 89 | 2.6 |
| | | Cu: 30 wt | | | AlN + 0.20 [symbol] % | | | | |
| | | alloy | | | Si | | | | |
| 374 | 317 | Cr (adhesion) | 0.1 | 91 | 99.90 [symbol] % GaN + 0.10 [symbol] % | 0.73 | Single crystal | 89 | 3.0 |
| | | Cu (low | 0.8 | | Mg | | | | |
| | | resistance) | | | | | | | |

TABLE 18

| | | | | | | Characteristics of the single crystal thin | | |
|---|---|---|---|---|---|---|---|---|
| | | | | | | film formed on the sintered compact | | |
| | Characteristics of the sintered compact substrate comprising | | | | | comprising an aluminum nitride as the | | |
| | an aluminum nitride as the main ingredients | | | | | main ingredients | | |
| | | | Characteristics of | | | | | Half width |
| | | | the sintered compact | | | | | of the (002) |
| | Powder compacts | | Total | | | | | X ray |
| | Additives | | amount | Amount | | Composition | Thickness | diffraction |
| | | Amount of | of | of | Optical | of the | of the | rocking |
| Experiment | Additive | addition | oxygen | ALON | transmissivity | single crystal | thin film | curve |
| No. | name | (volume %) *1) | (weight %) | (%) | (%) | thin film | (μm) | (second) |
| 375 | none | — | 0.9 | 1.3 | 44 | 100 mol % AlN | 3.0 | 192 |
| 376 | Al₂O₃ | 0.1 | 0.9 | 1.4 | 37 | 100 mol % AlN | 3.0 | 186 |
| 377 | Al₂O₃ | 3.0 | 2.6 | 6.9 | 21 | 100 mol % AlN | 3.0 | 195 |
| 378 | Al₂O₃ | 7.0 | 4.8 | 10 | 7.4 | 100 mol % AlN | 3.0 | 232 |
| 379 | Al₂O₃ | 12.0 | 7.7 | 17 | 3.9 | 100 mol % AlN | 3.0 | 273 |
| 380 | Al₂O₃ | 24.0 | 14.1 | 34 | 0.7 | 100 mol % AlN | 3.0 | 342 |
| 381 | Al₂O₃ | 36.0 | 20.7 | 47 | 0.0 | 100 mol % AlN | 3.0 | 417 |
| 382 | Al₂O₃ | 50.0 | 26.2 | 59 | 0.0 | 100 mol % AlN | 3.0 | polycrystal |
| | | | | | | | | (single |
| | | | | | | | | crystal is |
| | | | | | | | | not formed) |
| 383 | Al₂O₃ | 7.0 | 5.8 | 0.0 | 34 | 100 mol % AlN | 3.0 | 162 |
| | Y₂O₃ | 3.3 | | | | | | |
| 384 | Al₂O₃ | 12.0 | 8.6 | 0.0 | 23 | 100 mol % AlN | 3.0 | 176 |
| | Y₂O₃ | 3.3 | | | | | | |
| 385 | Al₂O₃ | 24.0 | 14.6 | 29 | 8.1 | 100 mol % AlN | 3.0 | 183 |
| | Er₂O₃ | 8.0 | | | | | | |
| 386 | Al₂O₃ | 36.0 | 22.4 | 33 | 8.5 | 100 mol % AlN | 3.0 | 224 |
| | Y₂O₃ | 10.0 | | | | | | |

*1) Amount of the additive is based on oxide conversion.

TABLE 19

| | | | | | | Characteristics of the single crystal thin | | |
|---|---|---|---|---|---|---|---|---|
| | Characteristics of the sintered compact substrate | | | | | film formed on the sintered compact | | |
| | comprising an aluminum nitride as the main ingredients | | | | | comprising an aluminum nitride as the | | |
| | | | Characteristics of the sintered | | | main ingredients | | |
| | | | compact *2) | | | | | Half width |
| | Powder compacts | | Total | | | | | of the (002) |
| Ex- | Additives | | amount | | | Composition | Thickness | X ray |
| peri- | | Amount of | of | Optical | Thermal | of the | of the | diffraction |
| ment | Additive | addition | oxygen | transmissivity | conductivity | single crystal | thin film | rocking curve |
| No. | name | (volume %) *1) | (weight %) | (%) | (W/mK) | thin film | (μm) | (second) |
| 387 | CaCO₃ | 0.5 | 0.9 | 46 | 177 | 100 mol % AlN | 3.0 | 132 |
| 388 | CaCO₃ | 7.5 | 2.6 | 4.6 | 131 | 100 mol % AlN | 3.0 | 206 |
| 389 | CaCO₃ | 25 | 7.9 | 2.5 | 101 | 100 mol % AlN | 3.0 | 277 |
| 390 | CaCO₃ | 45 | 14.6 | 0.4 | 59 | 100 mol % AlN | 3.0 | 503 |
| 391 | CaCO₃ | 54 | 16.4 | 0.0 | 44 | 100 mol % AlN | 3.0 | polycrystal |
| | | | | | | | | (single crystal |
| | | | | | | | | is not formed) |
| 392 | SrCO₃ | 3.0 | 1.6 | 13 | 134 | 100 mol % GaN | 3.0 | 174 |
| 393 | BaCO₃ | 30 | 5.7 | 4.0 | 112 | 100 mol % AlN | 3.0 | 375 |
| 394 | BeO | 40 | 24.5 | 0.0 | 109 | 100 mol % AlN | 3.0 | 219 |
| 395 | MgO | 5.0 | 3.2 | 7.1 | 58 | 100 mol % InN | 3.0 | 182 |
| 396 | Y₂O₃ | 0.1 | 0.8 | 52 | 130 | 100 mol % AlN | 3.0 | 140 |
| 397 | Y₂O₃ | 25 | 7.5 | 9.7 | 172 | 100 mol % AlN | 3.0 | 184 |
| 398 | Y₂O₃ | 45 | 13.1 | 0.5 | 124 | 100 mol % GaN | 3.0 | 387 |
| 399 | Y₂O₃ | 55 | 15.2 | 0.0 | 102 | 100 mol % AlN | 3.0 | polycrystal |
| | | | | | | | | (single crystal |
| | | | | | | | | is not formed) |
| 400 | CaCO₃ | 35 | 15.0 | 0.0 | 152 | 100 mol % AlN | 3.0 | 229 |
| | Y₂O₃ | 10 | | | | | | |
| 401 | BaCO₃ | 35 | 9.3 | 17 | 113 | 100 mol % AlN | 3.0 | 286 |
| | Y₂O₃ | 10 | | | | | | |
| 402 | Sm₂O₃ | 40 | 9.8 | 0.4 | 94 | 50 mol % AlN + | 3.0 | 290 |
| | | | | | | 50 mol % GaN | | |
| 403 | Gd₂O₃ | 20 | 5.8 | 7.8 | 120 | 100 mol % AlN | 3.0 | 234 |
| 404 | Dy₂O₃ | 20 | 5.7 | 8.5 | 134 | 100 mol % AlN | 3.0 | 228 |
| 405 | Ho₂O₃ | 40 | 9.6 | 0.4 | 102 | 100 mol % AlN | 3.0 | 331 |
| 406 | Er₂O₃ | 20 | 5.6 | 10.5 | 147 | 100 mol % AlN | 3.0 | 216 |
| 407 | Er₂O₃ | 45 | 9.6 | 0.7 | 106 | 100 mol % AlN | 3.0 | 366 |
| 408 | CaCO₃ | 43 | 14.8 | 0.0 | 66 | 100 mol % GaN | 3.0 | 263 |
| | Er₂O₃ | 2.0 | | | | | | |
| 409 | Yb₂O₃ | 30 | 7.3 | 3.6 | 105 | 100 mol % AlN | 3.0 | 299 |

*1) Amount of the additive is based on oxide conversion.
*2) Amount of the generation of ALON is zero altogether in the sintered compact of experiment No. 387-409.

TABLE 20

| | Characteristics of the sintered compact | | | | Characteristics of the single crystal thin | | |
|---|---|---|---|---|---|---|---|
| | substrate comprising an aluminum | | | | film formed on the sintered compact | | |
| | nitride as the main ingredients | | | | comprising an aluminum nitride as the | | |
| | | | Characteristics of | | main ingredients | | |
| | | | the sintered compact *2) | | | | Half width |
| | Powder compacts | | Total | | | | of the (002) |
| | Additives | | amount | | Composition | Thickness | X ray |
| | | Amount of | of | Optical | of the | of the | diffraction |
| Experiment | Additive | addition | oxygen | transmissivity | single crystal | thin film | rocking curve |
| No. | name | (volume %) *1) | (weight %) | (%) | thin film | (μm) | (second) |
| 410 | Li₂CO₃ | 2.0 | | | 100 mol % AlN | 3.0 | 220 |
| 411 | Li₂CO₃ | 15 | 6.4 | 0.0 | 100 mol % AlN | 3.0 | 643 |
| 412 | Li₂CO₃ | 25 | 10.7 | 0.0 | 100 mol % AlN | 3.0 | polycrystal |
| | | | | | | | (single crystal |
| | | | | | | | is not formed) |
| 413 | Li₂CO₃ | 2.0 | 2.5 | 14 | 100 mol % AlN | 3.0 | 168 |
| | Y₂O₃ | 3.3 | | | | | |
| 414 | Li₂CO₃ | 15 | 7.0 | 0.0 | 100 mol % AlN | 3.0 | 284 |
| | Er₂O₃ | 3.6 | | | | | |
| 415 | Li₂CO₃ | 15 | 7.9 | 0.0 | 100 mol % AlN | 3.0 | 227 |
| | Er₂O₃ | 8.0 | | | | | |
| | CaCO₃ | 0.5 | | | | | |
| 416 | Na₂CO₃ | 8.0 | 2.4 | 0.4 | 100 mol % AlN | 3.0 | 294 |
| 417 | K₂CO₃ | 4.0 | 1.5 | 2.2 | 100 mol % AlN | 3.0 | 205 |
| 418 | Si | 16 | 0.9 | 0.0 | 100 mol % AlN | 3.0 | 484 |
| 419 | Si | 25 | 1.0 | 0.0 | 100 mol % AlN | 3.0 | polycrystal |
| | | | | | | | (single crystal |
| | | | | | | | is not formed) |
| 420 | Si | 16 | 1.8 | 0.0 | 100 mol % AlN | 3.0 | 214 |
| | Er₂O₃ | 3.6 | | | | | |
| 421 | Si₃N₄ | 4.0 | 1.0 | 0.0 | 100 mol % AlN | 3.0 | 187 |
| 422 | SiC | 8.0 | 1.0 | 0.0 | 100 mol % AlN | 3.0 | 296 |
| 423 | SiO₂ | 2.5 | 2.1 | 6.5 | 100 mol % AlN | 3.0 | 192 |

*1) Amount of the additive is based on oxide conversion.
*2) Amount of the generation of ALON is zero altogether in the sintered compact of Experiment No. 410-423.

TABLE 21

| | Characteristics of the sintered compact | | | | Characteristics of the single crystal thin | | |
|---|---|---|---|---|---|---|---|
| | substrate comprising an aluminum | | | | film formed on the sintered compact | | |
| | nitride as the main ingredients | | | | comprising an aluminum nitride as the | | |
| | | | Characteristics of | | main ingredients | | |
| | | | the sintered compact *2) | | | | Half width |
| | Powder compacts | | Total | | | | of the (002) |
| | Additives | | amount | | Composition | Thickness | X ray |
| | | Amount of | of | Optical | of the | of the | diffraction |
| Experiment | Additive | addition | oxygen | transmissivity | single crystal | thin film | rocking curve |
| No. | name | (volume %) *1) | (weight %) | (%) | thin film | (μm) | (second) |
| 424 | MoO₃ | 0.4 | 0.8 | 26 | 100 mol % AlN | 3.0 | 146 |
| 425 | MoO₃ | 2.0 | 0.8 | 6.9 | 100 mol % AlN | 3.0 | 179 |
| 426 | MoO₃ | 4.0 | 0.8 | 3.3 | 100 mol % AlN | 3.0 | 184 |
| 427 | Mo | 8.0 | 0.8 | 0.7 | 100 mol % AlN | 3.0 | 214 |
| 428 | Mo | 12 | 0.8 | 0.6 | 100 mol % GaN | 3.0 | 233 |
| 429 | Mo | 24 | 0.9 | 0.0 | 100 mol % AlN | 3.0 | 276 |
| 430 | Mo | 42 | 0.9 | 0.0 | 100 mol % AlN | 3.0 | 424 |
| 431 | Mo | 55 | 0.8 | 0.0 | 100 mol % AlN | 3.0 | polycrystal |
| | | | | | | | (single crystal |
| | | | | | | | is not formed) |
| 432 | WO₃ | 0.2 | 0.8 | 24 | 100 mol % AlN | 3.0 | 155 |
| 433 | W | 15 | 0.8 | 0.8 | 100 mol % AlN | 3.0 | 236 |
| 434 | W | 30 | 0.8 | 0.0 | 100 mol % GaN | 3.0 | 337 |
| 435 | W | 55 | 0.7 | 0.0 | 100 mol % AlN | 3.0 | polycrystal |
| | | | | | | | (single crystal |
| | | | | | | | is not formed) |
| 436 | V₂O₅ | 4.0 | 0.9 | 2.4 | 100 mol % AlN | 3.0 | 194 |
| 437 | V | 16 | 0.9 | 0.6 | 100 mol % InN | 3.0 | 252 |
| 438 | V | 32 | 0.8 | 0.0 | 100 mol % AlN | 3.0 | 355 |
| 439 | TiO₂ | 2.0 | 0.8 | 7.4 | 100 mol % AlN | | 140 |
| 440 | TiO₂ | 12 | 0.9 | 0.0 | 50 mol % AlN + 50 mol % | 3.0 | 236 |
| | | | | | GaN | | |
| 441 | Nb₂O₅ | 7.5 | 0.8 | 0.8 | 100 mol % AlN | 3.0 | 233 |
| 442 | Nb | 15 | 0.8 | 0.4 | 50 mol % GaN + 50 mol % | 3.0 | 269 |
| | | | | | InN | | |
| 443 | Nb | 40 | 0.8 | 0.0 | 100 mol % AlN | 3.0 | 399 |
| 444 | Ta₂O₅ | 7.0 | 0.8 | 0.5 | 100 mol % AlN | 3.0 | 221 |
| 445 | Ta | 12 | 0.8 | 0.0 | 100 mol % AlN | 3.0 | 274 |
| 446 | Carbon | 1.5 | 0.3 | 7.7 | 100 mol % GaN | 3.0 | 165 |
| 447 | Carbon | 7.0 | 0.07 | 0.4 | 100 mol % AlN | 3.0 | 237 |
| 448 | Carbon | 15 | 0.02 | 0.0 | 100 mol % AlN | 3.0 | 286 |

*1) Amount of the additive is based on oxide conversion.
*2) Amount of the generation of ALON is zero altogether in the sintered compact of Experiment No. 424-448.

TABLE 22

| | Characteristics of the sintered compact | | | | Characteristics of the single crystal thin | | |
|---|---|---|---|---|---|---|---|
| | substrate comprising an aluminum | | | | film formed on the sintered compact | | |
| | nitride as the main ingredients | | | | comprising an aluminum nitride as the | | |
| | | | Characteristics of | | main ingredients | | |
| | | | the sintered compact *2) | | | | Half width |
| | Powder compacts | | Total | | | | of the (002) |
| | Additives | | amount | | Composition | Thickness | X ray |
| | | Amount of | of | Optical | of the | of the | diffraction |
| Experiment | Additive | addition | oxygen | transmissivity | single crystal | thin film | rocking curve |
| No. | name | (volume %) *1) | (weight %) | (%) | thin film | (μm) | (second) |
| 449 | MoO₃ | 2.0 | 1.9 | 17 | 100 mol % AlN | 3.0 | 135 |
| | Y₂O₃ | 3.3 | | | | | |
| 450 | MoO₃ | 4.0 | 2.0 | 11 | 100 mol % AlN | 3.0 | 136 |
| | Er₂O₃ | 3.6 | | | | | |
| 451 | Mo | 8.0 | 1.2 | 3.0 | 100 mol % AlN | 3.0 | 149 |
| | CaCO₃ | 1.0 | | | | | |
| 452 | Mo | 24 | 1.2 | 0.0 | 100 mol % AlN | 3.0 | 159 |
| | Y₂O₃ | 3.3 | | | | | |
| | CaCO₃ | 0.5 | | | | | |
| 453 | Mo | 42 | 0.9 | 0.0 | 100 mol % AlN | 3.0 | 208 |
| | Er₂O₃ | 3.6 | | | | | |
| | CaCO₃ | 0.5 | | | | | |
| 454 | W | 15 | 1.1 | 2.1 | 100 mol % AlN | 3.0 | 172 |
| | Er₂O₃ | 3.6 | | | | | |
| 455 | W | 30 | 0.7 | 0.0 | 100 mol % GaN | 3.0 | 216 |
| | Y₂O₃ | 3.3 | | | | | |
| | CaCO₃ | 0.5 | | | | | |
| 456 | V₂O₅ | 4.0 | 2.1 | 12 | 100 mol % AlN | 3.0 | 147 |
| | Er₂O₃ | 3.6 | | | | | |
| 457 | Carbon | 7.0 | 0.03 | 4.4 | 100 mol % AlN | 3.0 | 187 |
| | Y₂O₃ | 3.3 | | | | | |

*1) Amount of the additive is based on element conversion. However, amount of addition of the alkaline-earth metal and the rare earth metal ingredient is based on oxide conversion.
*2) Amount of the generation of ALON is zero altogether in the sintered compact of Experiment No. 449-457.

TABLE 23

| | Characteristics of the sintered compact | | | | Characteristics of the single crystal thin | | |
|---|---|---|---|---|---|---|---|
| | substrate comprising an aluminum | | | | film formed on the sintered compact | | |
| | nitride as the main ingredients | | | | comprising an aluminum nitride as the | | |
| | | | Characteristics of | | main ingredients | | |
| | | | the sintered compact *2) | | | | Half width |
| | Powder compacts | | Total | | | | of the (002) |
| | Additives | | amount | | Composition | Thickness | X ray |
| | | Amount of | of | Optical | of the | of the | diffraction |
| Experiment | Additive | addition | oxygen | transmissivity | single crystal | thin film | rocking curve |
| No. | name | (volume %) *1) | (weight %) | (%) | thin film | (μm) | (second) |
| 458 | Fe | 0.8 | 0.8 | 3.6 | 100 mol % AlN | 3.0 | 154 |
| 459 | Fe | 8.0 | 0.8 | 0.7 | 100 mol % AlN | 3.0 | 182 |
| 460 | Fe | 16 | 0.7 | 0.4 | 100 mol % GaN | 3.0 | 237 |
| 461 | Fe | 32 | 0.9 | 0.0 | 100 mol % AlN | 3.0 | 371 |
| 462 | Fe | 55 | 1.0 | 0.0 | 100 mol % AlN | 3.0 | polycrystal |
| | | | | | | | (single crystal |
| | | | | | | | is not formed) |
| 463 | Fe | 8.0 | 1.7 | 4.4 | 100 mol % AlN | 3.0 | 136 |
| | Y₂O₃ | 3.3 | | | | | |
| 464 | Fe | 16 | 1.4 | 1.5 | 100 mol % GaN | 3.0 | 161 |
| | Er₂O₃ | 3.6 | | | | | |
| 465 | Fe | 32 | 1.2 | 0.0 | 100 mol % AlN | 3.0 | 196 |
| | Y₂O₃ | 3.3 | | | | | |
| | CaCO₃ | 0.5 | | | | | |
| 466 | NiO | 3.5 | 0.9 | 0.7 | 100 mol % AlN | 3.0 | 177 |
| 467 | Ni | 42 | 0.8 | 0.0 | 100 mol % AlN | 3.0 | 396 |
| 468 | Ni | 42 | 1.7 | 0.0 | 100 mol % AlN | 3.0 | 188 |
| | Y₂O₃ | 3.3 | | | | | |
| 469 | Cr | 0.8 | 0.8 | 2.9 | 100 mol % AlN | 3.0 | 164 |
| 470 | Mn | 5.0 | 0.8 | 0.6 | 100 mol % AlN | 3.0 | 194 |
| 471 | Zr | 15 | 0.8 | 0.0 | 50 mol % AlN + 50 mol % | 3.0 | 221 |
| | | | | | GaN | | |
| 472 | Hf | 7.5 | 0.8 | 0.7 | 100 mol % AlN | 3.0 | 184 |
| 473 | CoO | 0.8 | 0.9 | 4.4 | 100 mol % AlN | 3.0 | 168 |
| 474 | CuO | 12 | 1.0 | 0.0 | 100 mol % InN | 3.0 | 233 |
| 475 | Zn | 3.0 | 0.8 | 0.4 | 100 mol % AlN | 3.0 | 169 |

*1) Amount of the additive is shown with weight % by element conversion. However, amount of addition of the alkaline-earth metal and the rare earth metal ingredient is shown with volume % by oxide conversion.
*2) Amount of the generation of ALON is zero altogether in the sintered compact of Experiment No. 458-475.

TABLE 24

| | | | | | Characteristics of the thin film conductivity | | |
|---|---|---|---|---|---|---|---|
| | Aluminum nitride sintered compacts in which the | | | | material formed on the thin film which | | |
| | thin film of various composition was formed | | | | comprises as the main ingredients | | |
| | Used | | | | a gallium nitride, an indium nitride, | | |
| | aluminum | | | | and an aluminum nitride | | |
| | nitride sintered | | | | | | Junction |
| | compact | | | | Composition | | strength |
| | (Experiment | Characteristics of the thin film | | | and | | with |
| | No. in which | | Thickness | | the constitution | | the thin film: |
| | the sintered | Composition | of the | Crystallized | of the thin film | | perpendicular |
| Experiment | compact was | of | thin film | state of | conductivity | Thickness | tension |
| No. | produced) | the thin film | (μm) | the thin film | material | (μm) | (Kg/mm²) |
| 476 | 269 | 100 mol % AlN | 3.0 | Single crystal | Ti | 0.2 | 4.2 |
| 477 | 49 | 100 mol % AlN | 3.0 | Amorphous | Ti | 0.2 | 3.6 |
| 478 | 49 | 100 mol % GaN | 3.0 | Single crystal | Ti | 0.2 | 4.0 |
| 479 | 49 | 100 mol % GaN | 3.0 | Amorphous | Ti | 0.2 | 2.9 |
| 480 | 49 | 100 mol % InN | 3.0 | Single crystal | Ti | 0.2 | 4.0 |
| 481 | 73 | 99.90 mol % GaN + 0.10 mol % | 3.0 | Single crystal | Ti | 0.2 | 3.5 |
| | | Mg | | | | | |
| 482 | 73 | 100 mol % AlN | 3.0 | Single crystal | Cr | 0.5 | 2.8 |
| 483 | 75 | 49.94 mol % GaN + 49.94 mol | 3.0 | Single crystal | Cr | 0.2 | 3.1 |
| | | AlN + 0.12 mol % | | | | | |
| | | Mg | | | | | |
| 484 | 75 | 50 mol % GaN + 50 mol % | 3.0 | Amorphous | Ni | 5.0 | 2.7 |
| | | AlN | | | | | |
| 485 | 80 | 100 mol % AlN | 3.0 | Orientated | Mo | 1.0 | 3.7 |
| | | | | polycrystal | | | |
| 486 | 82 | 99.94 mol % GaN + 0.06 mol % | 3.0 | Amorphous | W | 2.0 | 3.8 |
| | | Si | | | | | |
| 487 | 265 | 100 mol % AlN | 3.0 | Single crystal | W | 0.5 | 3.9 |
| 488 | 82 | 99.98 mol % AlN + 0.02 mol % | 3.0 | Single crystal | Pt | 0.5 | 2.5 |
| | | Si | | | | | |
| 489 | 110 | 100 mol % AlN | 3.0 | Single crystal | Al | 16 | 4.4 |
| 490 | 284 | 100 mol % AlN | 3.0 | Single crystal | Ni—Cr | 0.5 | 3.2 |
| 491 | 271 | 50 mol % GaN + 50 mol % | 3.0 | Single crystal | Ta | 0.6 | 3.4 |
| | | InN | | | | | |
| 492 | 305 | 100 mol % GaN | 3.0 | Single crystal | Ta₂N | 0.5 | 3.0 |
| 493 | 305 | 100 mol % InN | 3.0 | Amorphous | TiN | 0.5 | 4.0 |
| 494 | 311 | 100 mol % AlN | 3.0 | Single crystal | Ti (adhesion) | 0.1 | 5.1 |
| | | | | | Pt (barrier) | 0.2 | |
| | | | | | Au (low | 0.6 | |
| | | | | | resistance) | | |
| 495 | 311 | 100 mol % AlN | 3.0 | Single crystal | Ti (adhesion) | 0.1 | 5.4 |
| | | | | | W (barrier) | 0.5 | |
| | | | | | Au (low | 0.8 | |
| | | | | | resistance) | | |
| 496 | 317 | 49.94 mol % GaN + 49.94 mol | 3.0 | Single crystal | Ti (adhesion) | 0.1 | 5.2 |
| | | AlN + 0.12 mol % | | | Ni (barrier) | 1.8 | |
| | | Si | | | Au (low | 0.6 | |
| | | | | | resistance) | | |
| 497 | 317 | 100 mol % GaN | 3.0 | Single crystal | Cr (adhesion) | 0.1 | 4.4 |
| | | | | | Cu (low | 0.8 | |
| | | | | | resistance) | | |

TABLE 25

| | Thin films of various composition formed on the substrate which | | | | Characteristics of the thin film conductivity material | | | |
|---|---|---|---|---|---|---|---|---|
| | consists of a sintered compact which comprises AlN as the main | | | | formed on the thin film which comprises as the main | | | |
| | ingredients and formed beforehand the thin film conductivity material | | | | ingredients a gallium nitride, an indium nitride, and an | | | |
| | Thin film conductivity | | | | aluminum nitride | | | |
| | materials | | | | Composition | | Junction | |
| | formed beforehand | | | | and the | | strength | |
| | Experiment No. | Constitution | Characteristics of the thin film | | constitution | | with | |
| | in which | of | | Crystallized | of | | the thin film: | |
| Experi- | the AlN sintered | the thin film | Composition | state | the thin film | | perpendicular | |
| ment | compact | conductivity | of | of | conductivity | Thickness | tension | Reflec- |
| No. | was produced | material | the thin film | the thin film | material | (μm) | (Kg/mm²) | tance |
| 498 | 357 | Ti | 100 mol % GaN | Single crystal | TiN | 0.2 | 3.9 | 54 |
| 499 | 358 | Ti | 100 mol % AlN | Single crystal | Ti | 0.2 | 4.0 | |
| 500 | 359 | Ti | 99.94 mol % GaN + 0.06 mol % | Single crystal | Cr (adhesion) | 0.1 | 4.2 | 90 |
| | | | Si | | Cu (low | 0.8 | | |
| | | | | | resistance) | | | |
| 501 | 360 | Cr | 99.94 mol % InN + 0.06 mol % | Amorphous | Pt | 0.5 | 3.2 | 78 |
| | | | Si | | | | | |
| 502 | 361 | Ni | 19.98 mol % InN + 79.9 mol % | Single crystal | Ti (adhesion) | 0.1 | 5.9 | 92 |
| | | | GaN + 0.12 mol % | | Pt (barrier) | 0.2 | | |
| | | | Mg | | Au (low | 0.6 | | |
| | | | | | resistance) | | | |
| 503 | 362 | Mo | 19.98 mol % GaN + 79.9 mol % | Amorphous | Ti (adhesion) | 0.1 | 5.6 | 90 |
| | | | InN + 0.12 mol % | | W (barrier) | 0.5 | | |
| | | | Mg | | Au (low | 0.8 | | |
| | | | | | resistance) | | | |
| 504 | 363 | W | 49.94 mol % GaN + 49.94 mol | Amorphous | Ti (adhesion) | 0.1 | 5.3 | 91 |
| | | | AlN + 0.12 mol % | | Ni (barrier) | 1.8 | | |
| | | | Si | | Au (low | 0.6 | | |
| | | | | | resistance) | | | |
| 505 | 364 | W | 100 mol % InN | Amorphous | Cr | 0.5 | 2.6 | |
| 506 | 365 | Pt | 50 mol % GaN + 50 mol % | Single crystal | Ni | 1.0 | 2.7 | 67 |
| | | | AlN | | | | | |
| 507 | 366 | Al | 99.98 mol % AlN + 0.02 mol % | Amorphous | Mo | 0.5 | 3.5 | 55 |
| | | | Si | | | | | |
| 508 | 367 | NI—Cr | 100 mol % AlN | Amorphous | W | 0.2 | 3.8 | 53 |
| 509 | 368 | Ta | 49.94 mol % GaN + 49.94 mol | Single crystal | Al | 12 | 4.0 | 91 |
| | | | AlN + 0.12 mol % | | | | | |
| | | | Si | | | | | |
| 510 | 369 | Ta₂N | 100 mol % GaN | Amorphous | Ni—Cr | 0.5 | 3.3 | |
| 511 | 370 | TiN | 100 mol % InN | ingle crystal | Ta₂N | 0.5 | 3.1 | |
| 512 | 371 | Ti (adhesion) | 49.94 mol % GaN + 49.94 mol | Single crystal | Ti (adhesion) | 0.1 | 5.5 | 90 |
| | | Pt (barrier) | AlN + 0.12 mol % | | Pt (barrier) | 0.2 | | |
| | | Au (low | Mg | | Au (low | 0.6 | | |
| | | resistance) | | | resistance) | | | |
| 513 | 372 | Ti (adhesion) | 69.86 mol % GaN + 29.94 mol | Orientated | Ti (adhesion) | 0.1 | 5.2 | 90 |
| | | W (barrier) | AlN + 0.20 mol % | polycrystal | W (barrier) | 0.5 | | |
| | | Au (low | Mg | | Au (low | 0.8 | | |
| | | resistance) | | | resistance) | | | |
| 514 | 373 | W: 70 wt % | 69.86 mol % GaN + 29.94 mol | Single crystal | W: 90 wt % | 0.5 | 5.7 | 62 |
| | | Cu: 30 wt | AlN + 0.20 mol % | | Cu: 10 wt | | | |
| | | Alloy | Si | | Alloy | | | |
| 515 | 374 | Cr (adhesion) | 99.90 mol % GaN + 0.10 mol % | Single crystal | Cr (adhesion) | 0.1 | 4.4 | 92 |
| | | Cu (low | Mg | | Cu (low | 0.8 | | |
| | | resistance) | | | resistance) | | | |

TABLE 26

| | | Characteristics of the thin film which comprises as the main ingredients a gallium nitride, | | | | | | | |
|---|---|---|---|---|---|---|---|---|---|
| | Experiment No. | an indium nitride, and an aluminum nitride | | | | | | | |
| | in which | | | | | | | Formation direction | |
| | the used AlN | Composition of the thin film | | | | | Crystallized | of the C axis of a single | Refractive |
| Experiment | sintered compact | (mol %) | | | | | state of the | crystal thin film to the | index |
| No. | was produced | AlN | GaN | InN | NbN | TaN | thin film | substrate surface | (650 nm) |
| 516 | 49 | 100 | — | — | — | — | Single crystal | Perpendicular | 2.18861 |
| 517 | 58 | 100 | — | — | — | — | Single crystal | Perpendicular | 2.18860 |
| 518 | 269 | 100 | — | — | — | — | Single crystal | Perpendicular | 2.18861 |
| 519 | 49 | 99.99 | 0.01 | — | — | — | Single crystal | Perpendicular | 2.18864 |
| 520 | 49 | 99.90 | 0.10 | — | — | — | Single crystal | Perpendicular | 2.1889 |
| 521 | 49 | 99.0 | 1.0 | — | — | — | Single crystal | Perpendicular | 2.193 |
| 522 | 49 | 95.0 | 5.0 | — | — | — | Single crystal | Perpendicular | 2.199 |
| 523 | 49 | 90.0 | 10.0 | — | — | — | Single crystal | Perpendicular | 2.210 |
| 524 | 49 | 80.0 | 20.0 | — | — | — | Single crystal | Perpendicular | 2.239 |
| 525 | 49 | 70.0 | 30.0 | — | — | — | Single crystal | Perpendicular | 2.261 |
| 526 | 49 | 50.0 | 50.0 | — | — | — | Single crystal | Perpendicular | 2.319 |
| 527 | 49 | — | 100 | — | — | — | Single crystal | Perpendicular | 2.4670 |
| 528 | 49 | — | 99.9 | 0.10 | — | — | Single crystal | Perpendicular | 2.4675 |
| 529 | 49 | — | 90.0 | 10.0 | — | — | Single crystal | Perpendicular | 2.515 |
| 530 | 49 | 99.99 | — | 0.01 | — | — | Single crystal | Perpendicular | 2.18866 |
| 531 | 49 | 99.0 | — | 1.0 | — | — | Single crystal | Perpendicular | 2.194 |
| 532 | 49 | 90.0 | — | 10.0 | — | — | Single crystal | Perpendicular | 2.262 |
| 533 | 49 | 80.0 | — | 20.0 | — | — | Single crystal | Perpendicular | 2.335 |
| 534 | 49 | 50.0 | — | 50.0 | — | — | Single crystal | Perpendicular | 2.556 |
| 535 | 49 | — | — | 100 | — | — | Single crystal | Perpendicular | 2.894 |
| 536 | 269 | 99.98 | 0.01 | 0.01 | — | — | Single crystal | Perpendicular | 2.18869 |
| 537 | 269 | 99.0 | 0.50 | 0.50 | — | — | Single crystal | Perpendicular | 2.196 |
| 538 | 269 | 90.0 | 5.0 | 5.0 | — | — | Single crystal | Perpendicular | 2.242 |
| 539 | 269 | 70.0 | 15.0 | 15.0 | — | — | Single crystal | Perpendicular | 2.342 |
| 540 | 49 | 100 | — | — | — | — | Single crystal | Level | 2.14284 |
| 541 | 49 | 99.99 | 0.01 | — | — | — | Single crystal | Level | 2.14286 |
| 542 | 49 | 99.90 | 0.10 | — | — | — | Single crystal | Level | 2.1430 |
| 543 | 49 | 95.0 | 5.0 | — | — | — | Single crystal | Level | 2.151 |
| 544 | 49 | 80.0 | 20.0 | — | — | — | Single crystal | Level | 2.197 |
| 545 | 49 | 100 | — | — | — | — | Amorphous | — | 1.871 |
| 546 | 49 | 100 | — | — | — | — | Polycrystal | — | 1.893 |
| 547 | 49 | 80.0 | 20.0 | — | — | — | Amorphous | — | 1.907 |
| 548 | 49 | 80.0 | 20.0 | — | — | — | Polycrystal | — | 1.952 |
| 549 | 49 *1) | 100 | — | — | — | — | Single crystal | Perpendicular | 2.19582 |
| 550 | 49 *1) | 99.99 | — | — | 0.01 | — | Single crystal | Perpendicular | 2.19587 |
| 551 | 49 *1) | 99.90 | — | — | 0.10 | — | Single crystal | Perpendicular | 2.1971 |
| 552 | 49 *1) | 99.0 | — | — | 1.0 | — | Single crystal | Perpendicular | 2.205 |
| 553 | 49 *1) | 95.0 | — | — | 5.0 | — | Single crystal | Perpendicular | 2.238 |
| 554 | 49 *1) | 90.0 | — | — | 10.0 | — | Single crystal | Perpendicular | 2.276 |
| 555 | 49 *1) | 80.0 | — | — | 20.0 | — | Single crystal | Perpendicular | 2.352 |
| 556 | 49 *1) | 70.0 | — | — | 30.0 | — | Single crystal | Perpendicular | 2.438 |
| 557 | 49 *1) | 99.99 | — | — | — | 0.01 | Single crystal | Perpendicular | 2.19588 |
| 558 | 49 *1) | 99.90 | — | — | — | 0.10 | Single crystal | Perpendicular | 2.1982 |
| 559 | 49 *1) | 99.0 | — | — | — | 1.0 | Single crystal | Perpendicular | 2.207 |
| 560 | 49 *1) | 95.0 | — | — | — | 5.0 | Single crystal | Perpendicular | 2.244 |
| 561 | 49 *1) | 90.0 | — | — | — | 10.0 | Single crystal | Perpendicular | 2.283 |
| 562 | 49 *1) | 70.0 | — | — | — | 30.0 | Single crystal | Perpendicular | 2.445 |
| 563 | 49 *1) | 99.98 | — | — | 0.01 | 0.01 | Single crystal | Perpendicular | 2.19594 |
| 564 | 49 *1) | 99.90 | — | — | 0.05 | 0.05 | Single crystal | Perpendicular | 2.1979 |
| 565 | 49 *1) | 98.0 | — | — | 1.0 | 1.0 | Single crystal | Perpendicular | 2.215 |
| 566 | 49 *1) | 90.0 | — | — | 5.0 | 5.0 | Single crystal | Perpendicular | 2.289 |
| 567 | 49 *1) | 80.0 | — | — | 10.0 | 10.0 | Single crystal | Perpendicular | 2.363 |
| 568 | 49 *1) | — | 100 | — | — | — | Single crystal | Perpendicular | 2.4794 |
| 569 | 49 *1) | — | 99.9 | — | 0.10 | — | Single crystal | Perpendicular | 2.4796 |
| 570 | 49 *1) | — | 99.0 | — | 1.0 | — | Single crystal | Perpendicular | 2.484 |
| 571 | 49 *1) | — | — | 100 | — | — | Single crystal | Perpendicular | 2.9102 |
| 572 | 49 *1) | — | — | 99.9 | — | 0.10 | Single crystal | Perpendicular | 2.9104 |
| 573 | 49 *1) | — | — | 95.0 | — | 5.0 | Single crystal | Perpendicular | 2.917 |
| 574 | 49 *1) | 99.96 | 0.01 | 0.01 | 0.01 | 0.01 | Single crystal | Perpendicular | 2.19597 |
| 575 | 49 *1) | 96.0 | 1.0 | 1.0 | 1.0 | 1.0 | Single crystal | Perpendicular | 2.222 |
| 576 | 49 *1) | 90.0 | 2.5 | 2.5 | 2.5 | 2.5 | Single crystal | Perpendicular | 2.269 |
| 577 | 49 *1) | 80.0 | 5.0 | 5.0 | 5.0 | 5.0 | Single crystal | Perpendicular | 2.351 |

*1) Single crystal thin film is formed on the substrate which consists of the AlN sintered compact of Experiment No. 549-557 by the Chloride VPE method.

TABLE 27

| | | Characteristics of the thin film substrate using the sintered compact | | | | | Characteristics of the thin film | | |
|---|---|---|---|---|---|---|---|---|---|
| | | which comprises an aluminum nitride | | | | | substrate which carried out | | |
| | Used AlN | as the main ingredients and the bulk single | | | | | heat treatment after sputtering and | | |
| | sintered | crystal substrate | | | | | the bulk single crystal substrate | | |
| | compact | State of | Composition of the | Thin film | Crystallized | Refractive | Sputter | Refractive | Transmission |
| Experiment | (Experiment | the | thin film which formed | thickness | state of the | index | film | index | loss |
| No. | No.) | substrate | on the substrate | (μm) | thin film | (650 nm) | material | (650 nm) | (dB/cm) |
| 578 | 49 | A | 100 mol % AlN | 25 | Single crystal | 2.190 | GaN | 2.196 | 0.3 |
| 579 | 49 | thin film | 100 mol % AlN | 25 | Single crystal | 2.190 | InN | 2.198 | 0.5 |
| 580 | 49 | substrate | 100 mol % AlN | 25 | Single crystal | 2.190 | NbN | 2.200 | 0.7 |
| 581 | 49 | using the | 100 mol % AlN | 25 | Single crystal | 2.190 | TaN | 2.198 | 0.7 |
| 582 | 58 | sintered | 100 mol % AlN | 25 | Single crystal | 2.190 | GaN | 2.196 | 0.3 |
| 583 | 58 | compact | 100 mol % AlN | 25 | Single crystal | 2.190 | InN | 2.199 | 0.4 |
| 584 | 49 | which | 100 mol % AlN | 25 | Amorphous | 1.874 | GaN | 1.883 | 3.3 |
| 585 | 49 | comprises | 100 mol % AlN | 25 | Amorphous | 1.874 | InN | 1.878 | 3.4 |
| 586 | 49 | an | 100 mol % AlN | 25 | Amorphous | 1.874 | NbN | 1.881 | 3.6 |
| 587 | 49 | aluminum | 99 mol % AlN + | 25 | Single crystal | 2.191 | GaN | 2.196 | 0.4 |
| | | nitride | 1 mol % GaN | | | | | | |
| 588 | 49 | as | 90 mol % AlN + | 25 | Single crystal | 2.210 | GaN | 2.216 | 0.4 |
| | | the main | 10 mol % GaN | | | | | | |
| 589 | 49 | ingredient | 80 mol % AlN + | 25 | Single crystal | 2.244 | GaN | 2.250 | 0.4 |
| | | | 20 mol % GaN | | | | | | |
| 590 | 49 | | 50 mol % AlN + | 25 | Single crystal | 2.322 | GaN | 2.329 | 0.9 |
| | | | 50 mol % GaN | | | | | | |
| 591 | 49 | | 100 mol % GaN | 25 | Single crystal | 2.469 | InN | 2.472 | 1.4 |
| 592 | 49 | | 100 mol % GaN | 25 | Single crystal | 2.469 | NbN | 2.475 | 1.1 |
| 593 | 49 | | 100 mol % GaN | 25 | Single crystal | 2.469 | TaN | 2.477 | 1.3 |
| 594 | 49 | | 100 mol % GaN | 25 | Amorphous | 2.114 | NbN | 2.122 | 5.7 |
| 595 | 49 | | 90 [symbol] % AlN + | 25 | Single crystal | 2.263 | GaN | 2.266 | 0.6 |
| | | | 10 [symbol] % InN | | | | | | |
| 596 | 49 | | 99 mol % AlN + | 25 | Single crystal | 2.196 | GaN | 2.204 | 0.4 |
| | | | 0.5 mol % GaN + | | | | | | |
| | | | 0.5 mol % InN | | | | | | |
| 597 | 49 | | 90 mol % AlN + | 25 | Single crystal | 2.242 | NbN | 2.247 | 0.5 |
| | | | 5 mol % GaN + | | | | | | |
| | | | 5 mol % InN | | | | | | |
| 598 | 49 | | 70 mol % AlN + | 25 | Single crystal | 2.344 | TaN | 2.354 | 0.7 |
| | | | 15 mol % GaN + | | | | | | |
| | | | 15 mol % InN | | | | | | |
| 599 | 49 *1) | | 100 mol % AlN | 100 | Single crystal | 2.201 | GaN | 2.209 | ≦0.2 |
| 600 | 49 *1) | | 99 mol % AlN + | 100 | Single crystal | 2.206 | GaN | 2.213 | ≦0.2 |
| | | | 1 mol % GaN | | | | | | |
| 601 | 49 *1) | | 90 mol % AlN + | 100 | Single crystal | 2.219 | GaN | 2.224 | 0.3 |
| | | | 10 mol % GaN | | | | | | |
| 602 | 269 *1) | | 100 mol % AlN | 100 | Single crystal | 2.201 | GaN | 2.210 | ≦0.2 |
| 603 | 269 *1) | | 100 mol % AlN | 100 | Single crystal | 2.201 | InN | 2.207 | ≦0.2 |
| 604 | 269 *1) | | 100 mol % AlN | 100 | Single crystal | 2.201 | NbN | 2.209 | ≦0.2 |
| 605 | 269 *1) | | 100 mol % AlN | 100 | Single crystal | 2.201 | TaN | 2.210 | ≦0.2 |
| 606 | 269 *1) | | 100 mol % AlN | 100 | Single crystal | 2.201 | Ga₂O₃ | 2.208 | ≦0.2 |
| 607 | 269 *1) | | 100 mol % AlN | 100 | Single crystal | 2.201 | In₂O₃ | 2.209 | ≦0.2 |
| 608 | 269 *1) | | 100 mol % AlN | 100 | Single crystal | 2.201 | Nb₂O₅ | 2.211 | ≦0.2 |
| 609 | 269 *1) | | 100 mol % AlN | 100 | Single crystal | 2.201 | Ta₂O₅ | 2.210 | ≦0.2 |
| 610 | 49 *1) | | 100 mol % AlN | 100 | Single crystal | 2.201 | Nb | 2.211 | ≦0.2 |
| 611 | 49 *1) | | 100 mol % AlN | 100 | Single crystal | 2.201 | Ta | 2.213 | ≦0.2 |
| 612 | 269 *1) | | 100 mol % GaN | 100 | Single crystal | 2.484 | InN | 2.492 | 0.9 |
| 613 | — | AlN bulk | not formed | — | — | 2.211 | GaN | 2.220 | ≦0.2 |
| 614 | — | single | not formed | — | — | 2.211 | InN | 2.219 | ≦0.2 |
| 615 | — | crystal | not formed | — | — | 2.211 | NbN | 2.223 | ≦0.2 |
| 616 | — | | not formed | — | — | 2.211 | TaN | 2.218 | ≦0.2 |
| 617 | — | | not formed | — | — | 2.211 | Ga₂O₃ | 2.221 | ≦0.2 |
| 618 | — | | not formed | — | — | 2.211 | In₂O₃ | 2.217 | ≦0.2 |
| 619 | — | | not formed | — | — | 2.211 | Nb₂O₅ | 2.222 | ≦0.2 |
| 620 | — | | not formed | — | — | 2.211 | Ta₂O₅ | 2.219 | ≦0.2 |
| 621 | — | | not formed | — | — | 2.211 | Ga | 2.213 | ≦0.2 |
| 622 | — | | not formed | — | — | 2.211 | Nb | 2.221 | ≦0.2 |
| 623 | — | GaN bulk | not formed | — | — | 2.496 | InN | 2.504 | 0.8 |
| 624 | — | single | not formed | — | — | 2.496 | NbN | 2.506 | 0.9 |
| 625 | — | crystal | not formed | — | — | 2.496 | TaN | 2.507 | 0.8 |

*1) Single crystal thin film is formed on the substrate which consists of the AlN sintered compact of Experiment No. 599-612 by the Chloride VPE method.

TABLE 28

| | | | | | Ultraviolet rays transmission | | | |
|---|---|---|---|---|---|---|---|---|
| | Characteristics of the used substrate | | | | characteristics of the three | | | |
| | | | Sputter | Refractive index | dimension optical waveguide | | | |
| | State of | Composition of the | film material | of the | Transmission loss (dB/cm) | | | |
| Experiment | the | thin film which formed | (diffusion | waveguide portion | Measurement wavelength (nm) | | | |
| No. | substrate | on the substrate | material) | (650 nm) | 380 | 300 | 270 | 250 |
| 578 | A | 100 mol % AlN | GaN | 2.196 | 0.3 | 0.3 | 0.7 | 1.6 |
| 579 | thin film | 100 mol % AlN | InN | 2.198 | 0.5 | 0.6 | 0.8 | 1.8 |
| 580 | substrate | 100 mol % AlN | NbN | 2.200 | 0.7 | 0.7 | 0.8 | 1.9 |
| 581 | using the | 100 mol % AlN | TaN | 2.198 | 0.7 | 0.8 | 0.9 | 2.1 |
| 582 | sintered | 100 mol % AlN | GaN | 2.196 | 0.3 | 0.3 | 0.7 | 1.5 |
| 583 | compact | 100 mol % AlN | InN | 2.199 | 0.4 | 0.6 | 0.9 | 1.9 |
| 584 | which | 100 mol % AlN | GaN | 1.883 | 3.6 | 4.3 | 5.2 | 8.2 |
| 585 | comprises | 100 mol % AlN | InN | 1.878 | 3.9 | 4.7 | 5.8 | 8.9 |
| 586 | an | 100 mol % AlN | NbN | 1.881 | 4.1 | 4.8 | 6.1 | 9.4 |
| 587 | aluminum | 99 mol % AlN + | GaN | 2.196 | 0.4 | 0.4 | 0.8 | 1.6 |
| | nitride | 1 mol % GaN | | | | | | |
| 588 | as | 90 mol % AlN + | GaN | 2.216 | 0.4 | 0.5 | 0.8 | 2.5 |
| | the main | 10 mol % GaN | | | | | | |
| 589 | ingredient | 80 mol % AlN + | GaN | 2.250 | 0.4 | 0.5 | 0.9 | 4.4 |
| | | 20 mol % GaN | | | | | | |
| 590 | | 50 mol % AlN + | GaN | 2.329 | 1.1 | 2.4 | — | — |
| | | 50 mol % GaN | | | | | | |
| 591 | | 100 mol % GaN | InN | 2.472 | 2.4 | — | — | — |
| 592 | | 100 mol % GaN | NbN | 2.475 | 2.3 | — | — | — |
| 593 | | 100 mol % GaN | TaN | 2.477 | 2.7 | — | — | — |
| 594 | | 100 mol % GaN | NbN | 2.122 | 8.2 | — | — | — |
| 595 | | 90 [symbol] % AlN + | GaN | 2.266 | 0.6 | 0.6 | 2.4 | — |
| | | 10 [symbol] % InN | | | | | | |
| 596 | | 99 mol % AlN + | GaN | 2.204 | 0.4 | 0.4 | 0.9 | 2.1 |
| | | 0.5 mol % GaN + | | | | | | |
| | | 0.5 mol % InN | | | | | | |
| 597 | | 90 mol % AlN + | NbN | 2.247 | 0.5 | 0.6 | 1.7 | 2.7 |
| | | 5 mol % GaN + | | | | | | |
| | | 5 mol % InN | | | | | | |
| 598 | | 70 mol % AlN + | TaN | 2.354 | 0.8 | 7.6 | — | — |
| | | 15 mol % GaN + | | | | | | |
| | | 15 mol % InN | | | | | | |
| 599 | | 100 mol % AlN | GaN | 2.209 | 0.2 | 0.2 | 0.4 | 1.6 |
| 600 | | 99 mol % AlN + | GaN | 2.213 | 0.2 | 0.2 | 0.5 | 1.9 |
| | | 1 mol % GaN | | | | | | |
| 601 | | 90 mol % AlN + | GaN | 2.224 | 0.3 | 0.3 | 1.3 | 2.6 |
| | | 10 mol % GaN | | | | | | |
| 602 | | 100 mol % AlN | GaN | 2.210 | ≦0.2 | 0.2 | 0.4 | 2.1 |
| 603 | | 100 mol % AlN | InN | 2.207 | ≦0.2 | 0.2 | 0.6 | 2.5 |
| 604 | | 100 mol % AlN | NbN | 2.209 | ≦0.2 | 0.2 | 0.6 | 2.4 |
| 605 | | 100 mol % AlN | TaN | 2.210 | ≦0.2 | 0.2 | 0.7 | 2.6 |
| 606 | | 100 mol % AlN | Ga₂O₃ | 2.208 | ≦0.2 | 0.2 | 0.5 | 2.2 |
| 607 | | 100 mol % AlN | In₂O₃ | 2.209 | ≦0.2 | 0.2 | 0.6 | 2.7 |
| 608 | | 100 mol % AlN | Nb₂O₆ | 2.211 | ≦0.2 | 0.2 | 0.8 | 2.5 |
| 609 | | 100 mol % AlN | Ta₂O₆ | 2.210 | ≦0.2 | 0.2 | 0.7 | 2.6 |
| 610 | | 100 mol % AlN | Nb | 2.211 | ≦0.2 | 0.2 | 0.7 | 2.6 |
| 611 | | 100 mol % AlN | Ta | 2.213 | ≦0.2 | 0.2 | 0.7 | 2.7 |
| 612 | | 100 mol % GaN | InN | 2.492 | 1.6 | — | — | — |
| 613 | AlN bulk | not formed | GaN | 2.220 | ≦0.2 | 0.2 | 0.3 | 1.8 |
| 614 | single | not formed | InN | 2.219 | ≦0.2 | 0.2 | 0.5 | 2.1 |
| 615 | crystal | not formed | NbN | 2.223 | ≦0.2 | 0.2 | 0.5 | 2.0 |
| 616 | | not formed | TaN | 2.218 | ≦0.2 | 0.2 | 0.5 | 2.1 |
| 617 | | not formed | Ga₂O₃ | 2.221 | ≦0.2 | 0.2 | 0.4 | 1.9 |
| 618 | | not formed | In₂O₃ | 2.217 | ≦0.2 | 0.2 | 0.6 | 2.2 |
| 619 | | not formed | Nb₂O₆ | 2.222 | ≦0.2 | 0.2 | 0.5 | 2.3 |
| 620 | | not formed | Ta₂O₅ | 2.219 | ≦0.2 | 0.2 | 0.5 | 2.4 |
| 621 | | not formed | Ga | 2.213 | ≦0.2 | 0.2 | 0.3 | 1.8 |
| 622 | | not formed | Nb | 2.221 | ≦0.2 | 0.2 | 0.5 | 2.2 |
| 623 | GaN bulk | not formed | InN | 2.504 | 1.9 | — | — | — |
| 624 | single | not formed | NbN | 2.506 | 2.0 | — | — | — |
| 625 | crystal | not formed | TaN | 2.507 | 1.8 | — | — | — |

TABLE 29

| | Sputter film materials | | Refractive | | | | | |
|---|---|---|---|---|---|---|---|---|
| | (diffusion material) | | index | Optical transmission characteristics of | | | | |
| | | Thickness | of the formed | the three dimension optical waveguide | | | | |
| | | at the time | waveguide | Transmission loss (dB/cm) | | | | |
| Experiment | | of formation | portion *1) | Measurement wavelength (nm) | | | | |
| No. | Material | (nm) | (650 nm) | 650 | 380 | 300 | 270 | 250 |
| 626 | GaN | 1.0 | 2.19021 | 0.3 | 0.3 | 0.3 | 0.6 | 1.4 |
| 627 | GaN | 3.0 | 2.19031 | 0.4 | 0.4 | 0.4 | 0.6 | 1.5 |
| 628 | GaN | 10.0 | 2.19068 | 0.4 | 0.4 | 0.4 | 0.8 | 1.5 |
| 629 | GaN | 30.0 | 2.1929 | 0.4 | 0.4 | 0.5 | 0.8 | 1.6 |
| 630 | GaN | 100 | 2.1996 | 0.4 | 0.4 | 0.5 | 0.8 | 2.1 |
| 631 | GaN | 300 | 2.2182 | 0.4 | 0.4 | 0.5 | 0.8 | 2.8 |
| 632 | GaN | 1000 | 2.2740 | 0.8 | 1.1 | 2.4 | — | — |
| 633 | InN | 1.0 | 2.19023 | 0.5 | 0.5 | 0.6 | 0.7 | 1.7 |
| 634 | InN | 10.0 | 2.19247 | 0.5 | 0.5 | 0.5 | 1.1 | 1.9 |
| 635 | InN | 100 | 2.2133 | 0.6 | 0.6 | 0.7 | 1.6 | 2.5 |
| 636 | InN | 400 | 2.2839 | 0.7 | 1.1 | 2.7 | — | — |
| 637 | NbN | 1.0 | 2.19026 | 0.7 | 0.7 | 0.7 | 0.7 | 1.8 |
| 638 | NbN | 10.0 | 2.19254 | 0.7 | 0.7 | 0.8 | 0.8 | 1.8 |
| 639 | NbN | 100 | 2.2141 | 0.7 | 0.7 | 0.8 | 1.5 | 2.4 |
| 640 | NbN | 400 | 2.2977 | 0.8 | 0.7 | 2.6 | — | — |
| 641 | TaN | 1.0 | 2.19024 | 0.7 | 0.7 | 0.7 | 0.8 | 1.6 |
| 642 | TaN | 10.0 | 2.19258 | 0.7 | 0.7 | 0.8 | 0.8 | 1.9 |
| 643 | TaN | 100 | 2.2152 | 0.7 | 0.7 | 0.8 | 1.3 | 2.7 |
| 644 | TaN | 400 | 2.2994 | 0.9 | 1.0 | 2.8 | — | — |

*1) Refractive index of the single crystal thin film before forming the sputter film is 2.19017 in light with a wavelength of 650 nm.

TABLE 30

| | | Characteristics of the thin film optical waveguide which | | | | | | | | |
|---|---|---|---|---|---|---|---|---|---|---|
| | | comprises as the main ingredients a gallium nitride, | | | | | | | | |
| | | an indium nitride, and an aluminum nitride | | | | | | | | |
| | Used | | | | | | | Transmission | | |
| | AlN sintered | | | | | | | loss (dB/cm) | | |
| | ompact | Composition of the single crystal | | | | | | Measurement | | |
| Experiment | (Experiment | thin film waveguide (mol %) | | | | | Form of the | wavelength (nm) | | |
| No. | No.) | AlN | GaN | InN | NbN | TaN | optical waveguide | 650 | 300 | 250 |
| 645 | 49 | 100 | — | — | — | — | Three dimension | 0.6 | 0.7 | 2.1 |
| 646 | 58 | 100 | — | — | — | — | Three dimension | 0.6 | 0.7 | 2.1 |
| 647 | 269 | 100 | — | — | — | — | Three dimension | 0.6 | 0.7 | 2.0 |
| 648 | 49 | 99.99 | 0.01 | — | — | — | Three dimension | 0.7 | 0.7 | 1.9 |
| 649 | 49 | 99.90 | 0.10 | — | — | — | Three dimension | 0.6 | 0.7 | 2.4 |
| 650 | 49 | 99.0 | 1.0 | — | — | — | Three dimension | 0.8 | 0.7 | 2.2 |
| 651 | 49 | 95.0 | 5.0 | — | — | — | Three dimension | 0.7 | 0.9 | 2.6 |
| 652 | 49 | 90.0 | 10.0 | — | — | — | Three dimension | 0.7 | 0.7 | 2.4 |
| 653 | 49 | 80.0 | 20.0 | — | — | — | Three dimension | 0.9 | 1.1 | 2.6 |
| 654 | 49 | 70.0 | 30.0 | — | — | — | Three dimension | 0.7 | 0.7 | — |
| 655 | 49 | 50.0 | 50.0 | — | — | — | Three dimension | 0.8 | 2.7 | — |
| 656 | 49 | — | 100 | — | — | — | Three dimension | 0.8 | — | — |
| 657 | 49 | — | 99.9 | 0.10 | — | — | Three dimension | 0.9 | — | — |
| 658 | 49 | — | 90.0 | 10.0 | — | — | Three dimension | 0.7 | — | — |
| 659 | 269 | 99.99 | — | 0.01 | — | — | Three dimension | 0.6 | 0.7 | 2.4 |
| 660 | 269 | 99.0 | — | 1.0 | — | — | Three dimension | 0.7 | 0.7 | 2.8 |
| 661 | 269 | 90.0 | — | 10.0 | — | — | Three dimension | 0.8 | 1.7 | — |
| 662 | 269 | 80.0 | — | 20.0 | — | — | Three dimension | 0.7 | 2.9 | — |
| 663 | 269 | 50.0 | — | 50.0 | — | — | Three dimension | 1.1 | — | — |
| 664 | 269 | — | — | 100 | — | — | Three dimension | 2.7 | — | — |
| 665 | 49 | 99.98 | 0.01 | 0.01 | — | — | Three dimension | 0.7 | 0.7 | 1.8 |
| 666 | 49 | 90.0 | 5.0 | 5.0 | — | — | Three dimension | 0.8 | 0.8 | 2.2 |
| 667 | 49 | 80.0 | 10.0 | 10.0 | — | — | Three dimension | 0.7 | 2.6 | — |
| 668 | 49 | 70.0 | 15.0 | 15.0 | — | — | Three dimension | 0.7 | — | — |
| 669 | 49 *1) | 100 | — | — | — | — | Three dimension | 0.9 | 0.9 | 2.6 |
| 670 | 49 *1) | 99.99 | 0.01 | — | — | — | Three dimension | 0.8 | 0.9 | 2.7 |
| 671 | 49 *1) | 99.90 | 0.10 | — | — | — | Three dimension | 0.8 | 0.9 | 2.4 |
| 672 | 49 *1) | 95.0 | 5.0 | — | — | — | Three dimension | 0.8 | 0.9 | 2.8 |
| 673 | 49 *1) | 80.0 | 20.0 | — | — | — | Three dimension | 0.8 | 1.3 | 2.8 |
| 674 | 49 | 100 | — | — | — | — | Two dimension | 0.3 | 0.4 | 1.9 |
| 675 | 49 | 99.90 | 0.10 | — | — | — | Two dimension | 0.3 | 0.3 | 1.8 |
| 676 | 49 | 95.0 | 5.0 | — | — | — | Two dimension | 0.3 | 0.5 | 2.4 |
| 677 | 49 | 80.0 | 20.0 | — | — | — | Two dimension | 0.3 | 0.8 | 2.7 |
| 678 | 49 | 99.99 | — | — | 0.01 | — | Three dimension | 0.8 | 0.7 | 2.0 |
| 679 | 49 | 99.90 | — | — | 0.10 | — | Three dimension | 0.7 | 0.8 | 2.2 |
| 680 | 49 | 99.0 | — | — | 1.0 | — | Three dimension | 0.7 | 0.6 | 2.6 |
| 681 | 49 | 95.0 | — | — | 5.0 | — | Three dimension | 0.8 | 0.8 | 2.5 |
| 682 | 49 | 90.0 | — | — | 10.0 | — | Three dimension | 0.7 | 2.7 | — |
| 683 | 49 | 80.0 | — | — | 20.0 | — | Three dimension | 0.8 | — | — |
| 684 | 49 | 70.0 | — | — | 30.0 | — | Three dimension | 0.9 | — | — |
| 685 | 49 | 99.99 | — | — | — | 0.01 | Three dimension | 0.7 | 0.7 | 2.0 |
| 686 | 49 | 99.90 | — | — | — | 0.10 | Three dimension | 0.7 | 0.8 | 1.9 |
| 687 | 49 | 99.0 | — | — | — | 1.0 | Three dimension | 0.8 | 0.7 | 2.1 |
| 688 | 49 | 95.0 | — | — | — | 5.0 | Three dimension | 0.9 | 0.7 | 2.6 |
| 689 | 49 | 90.0 | — | — | — | 10.0 | Three dimension | 0.8 | 2.7 | — |
| 690 | 49 | 70.0 | — | — | — | 30.0 | Three dimension | 0.9 | 0.7 | — |
| 691 | 49 | 99.98 | — | — | 0.01 | 0.01 | Three dimension | 0.7 | 0.8 | 2.3 |
| 692 | 49 | 99.90 | — | — | 0.05 | 0.05 | Three dimension | 0.7 | 0.7 | 2.1 |
| 693 | 49 | 98.0 | — | — | 1.0 | 1.0 | Three dimension | 0.8 | 0.9 | 2.9 |
| 694 | 49 | 90.0 | — | — | 5.0 | 5.0 | Three dimension | 0.7 | 2.6 | — |
| 695 | 49 | 80.0 | — | — | 10.0 | 10.0 | Three dimension | 0.9 | — | — |
| 696 | 49 | — | 99.9 | — | 0.10 | — | Three dimension | 0.8 | — | — |
| 697 | 49 | — | 99.0 | — | 1.0 | — | Three dimension | 0.7 | — | — |
| 698 | 49 | — | — | 99.9 | — | 0.10 | Three dimension | 2.1 | — | — |
| 699 | 49 | — | — | 95.0 | — | 5.0 | Three dimension | 2.6 | — | — |
| 700 | 49 | 99.96 | 0.01 | 0.01 | 0.01 | 0.01 | Three dimension | 0.7 | 0.7 | 2.6 |
| 701 | 49 | 99.80 | 0.05 | 0.05 | 0.05 | 0.05 | Three dimension | 0.7 | 0.9 | 2.5 |
| 702 | 49 | 98.0 | 0.5 | 0.5 | 0.5 | 0.5 | Three dimension | 0.8 | 1.3 | 2.8 |
| 703 | 49 | 90.0 | 2.5 | 2.5 | 2.5 | 2.5 | Three dimension | 0.8 | 1.5 | — |
| 704 | 49 | 80.0 | 5.0 | 5.0 | 5.0 | 5.0 | Three dimension | 0.9 | 2.8 | — |
| 705 | 49 | 70.0 | 7.5 | 7.5 | 7.5 | 7.5 | Three dimension | 1.4 | — | — |

*1) Polycrystalline thin film of an aluminum nitride is not formed on the aluminum nitride sintered compact substrate of Experiment No. 669-673.

TABLE 31

| | | Characteristics of the thin film formed on the sintered compact | | | | | | |
|---|---|---|---|---|---|---|---|---|
| | | which comprises an aluminum nitride as the main ingredients | | | | | | |
| | | | | | | | Half width of the (002) | Surface |
| | | Formation | | | | | X ray diffraction rocking | roughness |
| | Contents of | state and | Production | | | | curve of the single crystal | of |
| | the used | formation | method of | Composition | Thin film | Crystallized state | thin film and | the thin film |
| Experiment | AlN | position of | the | of | thickness | of | the orientated polycrystal | substrate |
| No. | substrate | the thin film | thin film | the thin film | (μm) | the thin film | (second) | Ra (nm) |
| 706 | produced | Single layer | Sputter | 100% AlN | 3.0 | Amorphous | — | 3.9 |
| 707 | in | Single layer | Sputter | 100% AlN | 3.0 | Polycrystal | — | 3.2 |
| 708 | Experiment | Single layer | Sputter | 100% AlN | 3.0 | Orientated polycrystal | 7910 | 1.9 |
| 709 | No. 49 | Single layer | MOCVD | 100% AlN | 3.0 | Single crystal | 187 | 6.7 |
| 710 | | Substrate side | Sputter | 100% AlN | 3.0 | Amorphous | — | 4.1 |
| | | Surface layer | MOCVD | 100% AlN | 3.0 | Single crystal | 89 | 2.4 |
| 711 | | Substrate side | Sputter | 100% AlN | 3.0 | Polycrystal | — | 3.4 |
| | | Surface layer | MOCVD | 100% AlN | 3.0 | Single crystal | 93 | 2.0 |
| 712 | | Substrate side | Sputter | 100% AlN | 3.0 | Orientated polycrystal | 7640 | 1.7 |
| | | Surface layer | MOCVD | 100% AlN | 3.0 | Single crystal | 79 | 0.94 |
| 713 | | Substrate side | MOCVD | 100% AlN | 3.0 | Single crystal | 184 | 6.6 |
| | | Surface layer | MOCVD | 100% AlN | 3.0 | Single crystal | 105 | 2.9 |
| 714 | | Single layer | MOCVD | 100% GaN | 3.0 | Single crystal | 179 | 5.9 |
| 715 | | Single layer | MOCVD | 100% InN | 3.0 | Single crystal | 194 | 5.0 |
| 716 | | Substrate side | Sputter | 100% AlN | 3.0 | Orientated polycrystal | 8290 | 1.8 |
| | | Surface layer | MOCVD | 100% GaN | 3.0 | Single crystal | 89 | 0.97 |
| 717 | | Substrate side | Sputter | 100% AlN | 3.0 | Orientated polycrystal | 7810 | 1.6 |
| | | Surface layer | MOCVD | 100% InN | 3.0 | Single crystal | 87 | 1.04 |
| 718 | | Substrate side | Sputter | 100% AlN | 3.0 | Amorphous | — | 3.8 |
| | | Surface layer | MOCVD | 100% GaN | 3.0 | Single crystal | 90 | 2.2 |
| 719 | | Substrate side | Sputter | 100% AlN | 3.0 | Polycrystal | — | 3.1 |
| | | Surface layer | MOCVD | 100% GaN | 3.0 | Single crystal | 92 | 2.3 |
| 720 | | Substrate side | MOCVD | 100% AlN | 3.0 | Single crystal | 179 | 6.9 |
| | | Surface layer | MOCVD | 100% GaN | 3.0 | Single crystal | 107 | 3.0 |
| 721 | | Single layer | MOCVD | 100% AlN | 3.0 | Orientated polycrystal | 4970 | 1.9 |
| 722 | | Single layer | IP *1) | 100% AlN | 3.0 | Polycrystal | — | 4.2 |
| 723 | | Substrate side | MOCVD | 100% AlN | 3.0 | Orientated polycrystal | 4880 | 1.8 |
| | | Surface layer | MOCVD | 100% AlN | 3.0 | Single crystal | 87 | 0.87 |
| 724 | | Substrate side | IP *1) | 100% AlN | 3.0 | Polycrystal | — | 3.7 |
| | | Surface layer | MOCVD | 100% AlN | 3.0 | Single crystal | 90 | 2.2 |
| 725 | | Single layer | CV *2) | 100% AlN | 3.0 | Single crystal | 177 | 7.6 |
| 726 | | Substrate side | Sputter | 100% AlN | 3.0 | Amorphous | — | 3.7 |
| | | Surface layer | CV *2) | 100% AlN | 3.0 | Single crystal | 91 | 2.5 |
| 727 | | Substrate side | Sputter | 100% AlN | 3.0 | Orientated polycrystal | 8320 | 1.7 |
| | | Surface layer | CV *2) | 100% AlN | 3.0 | Single crystal | 86 | 1.09 |
| 728 | | Single layer | MOCVD | 100% GaN | 3.0 | Amorphous | — | 3.1 |
| 729 | | Single layer | MOCVD | 100% GaN | 3.0 | Polycrystal | — | 3.3 |
| 730 | | Single layer | MOCVD | 100% GaN | 3.0 | Orientated polycrystal | 4710 | 1.7 |
| 731 | | Single layer | MOCVD | 100% InN | 3.0 | Orientated polycrystal | 4820 | 1.6 |
| 732 | | Substrate side | MOCVD | 100% GaN | 3.0 | Amorphous | — | 3.4 |
| | | Surface layer | MOCVD | 100% AlN | 3.0 | Single crystal | 93 | 2.5 |
| 733 | | Substrate side | MOCVD | 100% GaN | 3.0 | Polycrystal | — | 3.6 |
| | | Surface layer | MOCVD | 100% GaN | 3.0 | Single crystal | 93 | 2.6 |
| 734 | | Substrate side | MOCVD | 100% GaN | 3.0 | Orientated polycrystal | 4590 | 1.8 |
| | | Surface layer | MOCVD | 100% AlN | 3.0 | Single crystal | 87 | 1.07 |
| 735 | | Substrate side | MOCVD | 100% GaN | 3.0 | Orientated polycrystal | 4640 | 1.5 |
| | | Surface layer | MOCVD | 100% GaN | 3.0 | Single crystal | 87 | 0.97 |
| 736 | | Substrate side | MOCVD | 100% GaN | 3.0 | Orientated polycrystal | 4650 | 1.7 |
| | | Surface layer | MOCVD | 100% InN | 3.0 | Single crystal | 89 | 1.11 |
| 737 | | Substrate side | MOCVD | 100% InN | 3.0 | Orientated polycrystal | 4860 | 1.6 |
| | | Surface layer | MOCVD | 100% AlN | 3.0 | Single crystal | 94 | 1.03 |
| 738 | | Substrate side | MOCVD | 100% InN | 3.0 | Orientated polycrystal | 4790 | 1.7 |
| | | Surface layer | MOCVD | 100% GaN | 3.0 | Single crystal | 91 | 1.08 |
| 739 | | Substrate side | MOCVD | 100% InN | 3.0 | Orientated polycrystal | 4810 | 1.5 |
| | | Surface layer | MOCVD | 100% InN | 3.0 | Single crystal | 90 | 1.02 |

*1) IP: It is the abbreviation of the ion plating method.
*2) CV: It is the abbreviation of the Chloride VPE method.

TABLE 32

| | | Characteristics of the thin film formed on the sintered compact | | | | | | |
|---|---|---|---|---|---|---|---|---|
| | | which comprises an aluminum nitride as the main ingredients | | | | | | |
| | | | | | | | Half width of the (002) | Surface |
| | | Formation | | | | | X ray diffraction rocking | roughness |
| | Contents of | state and | Production | | | | curve of the single crystal | of |
| | the used | formation | method of | Composition | Thin film | Crystallized state | thin film and | the thin film |
| Experiment | AlN | position of | the | of | thickness | of | the orientated polycrystal | substrate |
| No. | substrate | the thin film | thin film | the thin film | (μm) | the thin film | (second) | Ra (nm) |
| 740 | produced | Single layer | MOCVD | 100% AlN | 3.0 | Single crystal | 191 | 7.0 |
| 741 | in | Substrate side | Sputter | 100% AlN | 3.0 | Amorphous | — | 4.0 |
| | Experiment | Surface layer | MOCVD | 100% AlN | 3.0 | Single crystal | 91 | 2.6 |
| 742 | No. 58 | Substrate side | Sputter | 100% AlN | 3.0 | Orientated polycrystal | 7640 | 1.4 |
| | | Surface layer | MOCVD | 100% AlN | 3.0 | Single crystal | 88 | 0.99 |
| 743 | | Substrate side | Sputter | 100% AlN | 3.0 | Orientated polycrystal | 7510 | 1.6 |
| | | Surface layer | MOCVD | 100% GaN | 3.0 | Single crystal | 87 | 0.97 |
| 744 | produced | Single layer | MOCVD | 100% AlN | 3.0 | Single crystal | 95 | 6.7 |
| 745 | in | Substrate side | Sputter | 100% AlN | 3.0 | Orientated polycrystal | 7270 | 1.4 |
| | Experiment | Surface layer | MOCVD | 100% AlN | 3.0 | Single crystal | 85 | 0.99 |
| 746 | No. 259 | Substrate side | MOCVD | 100% AlN | 3.0 | Orientated polycrystal | 4890 | 1.8 |
| | | Surface layer | MOCVD | 100% AlN | 3.0 | Single crystal | 83 | 0.94 |
| 747 | | Substrate side | Sputter | 100% AlN | 3.0 | Orientated polycrystal | 7410 | 1.6 |
| | | Surface layer | MOCVD | 100% GaN | 3.0 | Single crystal | 87 | 0.96 |
| 748 | | Substrate side | Sputter | 100% AlN | 3.0 | Orientated polycrystal | 7560 | 1.7 |
| | | Surface layer | MOCVD | 100% InN | 3.0 | Single crystal | 93 | 1.02 |
| 749 | produced | Single layer | MOCVD | 100% AlN | 3.0 | Single crystal | 137 | 6.2 |
| 750 | in | Substrate side | Sputter | 100% AlN | 3.0 | Polycrystal | — | 3.7 |
| | Experiment | Surface layer | MOCVD | 100% AlN | 3.0 | Single crystal | 89 | 2.3 |
| 751 | No. 266 | Substrate side | Sputter | 100% AlN | 3.0 | Orientated polycrystal | 7110 | 1.7 |
| | | Surface layer | MOCVD | 100% AlN | 3.0 | Single crystal | 86 | 0.95 |
| 752 | | Substrate side | Sputter | 100% AlN | 3.0 | Orientated polycrystal | 7440 | 1.6 |
| | | Surface layer | MOCVD | 100% GaN | 3.0 | Single crystal | 89 | 0.97 |
| 753 | produced | Single layer | MOCVD | 100% AlN | 3.0 | Single crystal | 93 | 6.2 |
| 754 | in | Substrate side | Sputter | 100% AlN | 3.0 | Orientated polycrystal | 7330 | 1.5 |
| | Experiment | Surface layer | MOCVD | 100% AlN | 3.0 | Single crystal | 85 | 0.97 |
| 755 | No. 269 | Substrate side | Sputter | 100% AlN | 3.0 | Amorphous | — | 4.3 |
| | | Surface layer | MOCVD | 100% GaN | 3.0 | Single crystal | 90 | 2.1 |
| 756 | | Substrate side | Sputter | 100% AlN | 3.0 | Orientated polycrystal | 7270 | 1.7 |
| | | Surface layer | MOCVD | 100% GaN | 3.0 | Single crystal | 82 | 0.99 |
| 757 | | Substrate side | Sputter | 100% AlN | 3.0 | Orientated polycrystal | 7520 | 1.6 |
| | | Surface layer | MOCVD | 100% InN | 3.0 | Single crystal | 90 | 1.04 |
| 758 | produced | Substrate side | Sputter | 100% AlN | 3.0 | Orientated polycrystal | 8060 | 1.8 |
| | in | Surface layer | MOCVD | 100% AlN | 3.0 | Single crystal | 89 | 0.95 |
| 759 | Experiment | Substrate side | MOCVD | 100% InN | 3.0 | Orientated polycrystal | 4820 | 1.6 |
| | No. 80 | Surface layer | MOCVD | 100% GaN | 3.0 | Single crystal | 94 | 0.98 |
| 760 | produced | Substrate side | Sputter | 100% AlN | 3.0 | Amorphous | — | 4.4 |
| | in | Surface layer | CV *1) | 100% AlN | 3.0 | Single crystal | 90 | 2.4 |
| 761 | Experiment | Substrate side | MOCVD | 100% GaN | 3.0 | Orientated polycrystal | 4610 | 1.6 |
| | No. 83 | Surface layer | MOCVD | 100% GaN | 3.0 | Single crystal | 85 | 0.93 |
| 762 | produced | Substrate side | Sputter | 100% AlN | 3.0 | Orientated polycrystal | 8270 | 1.3 |
| | in | Surface layer | MOCVD | 100% AlN | 3.0 | Single crystal | 95 | 0.98 |
| 763 | Experiment | Substrate side | MOCVD | 100% InN | 3.0 | Orientated polycrystal | 4850 | 1.5 |
| | No. 304 | Surface layer | MOCVD | 100% InN | 3.0 | Single crystal | 85 | 0.95 |
| 764 | produced | Substrate side | Sputter | 100% AlN | 3.0 | Polycrystal | — | 3.6 |
| | in this | Surface layer | MOCVD | 100% AlN | 3.0 | Single crystal | 94 | 2.6 |
| 765 | Example *2) | Substrate side | MOCVD | 100% GaN | 3.0 | Orientated polycrystal | 4590 | 1.8 |
| | | Surface layer | MOCVD | 100% AlN | 3.0 | Single crystal | 88 | 0.96 |

*1) CV: It is the abbreviation of the Chloride VPE method.
*2) AlN sintered compact which includes Er2O3 4.02 volume % and which formed the tungsten conduction via containing AlN 5.0 weight %

TABLE 33

| | | Characteristics of the thin film which formed on the sintered compact which comprises | | | | | | |
|---|---|---|---|---|---|---|---|---|
| | | an aluminum nitride as the main ingredients | | | | | | |
| | | | | | | | Half width of the | |
| | | Formation | | | | | (002) X ray diffraction | Surface |
| | | state and | | | | Electric | rocking curve of the | roughness |
| | Content of | formation | Production | | Crystallized | resistivity of | single crystal thin | of the |
| | the used | position | method | Composition | state | the thin film | film and the | thin film |
| Experiment | AlN | of the | of the | of | of | (Ω · cm) (room | orientated polycrystal | substrate |
| No. | substrate | thin film | thin film | the thin film | the thin film | temperature) | (second) | Ra (nm) |
| 766 | produced | Single | Sputter | 99.98 mol % GaN + | Amorphous | 0.14 | — | 4.4 |
| | in | layer | | 0.02 mol % Si | | | | |
| 767 | Experiment | Single | Sputter | 99.98 mol % InN + | Polycrystal | 0.084 | — | 3.7 |
| | No. 49 | layer | | 0.02 mol % Si | | | | |
| 768 | | Single | Sputter | 99.98 mol % AlN + | Orientated | 115 | 7930 | 1.5 |
| | | layer | | 0.02 mol % Si | polycrystal | | | |
| 769 | | Single | MOCVD | 99.98 mol % AlN + | Orientated | 91 | 4560 | 1.7 |
| | | layer | | 0.02 mol % Si | polycrystal | | | |
| 770 | | Single | MOCVD | 49.99 mol % AlN + | Orientated | 0.87 | 4390 | 1.6 |
| | | layer | | 49.99 mol % GaN + | polycrystal | | | |
| | | | | 0.02 mol % Si | | | | |
| 771 | | Single | MOCVD | 99.98 mol % AlN + | Single | 89 | 171 | 7.1 |
| | | layer | | 0.02 mol % Si | crystal | | | |
| 772 | | Single | MOCVD | 99.98 mol % GaN + | Single | 0.019 | 157 | 6.3 |
| | | layer | | 0.02 mol % Si | crystal | | | |
| 773 | | Single | MOCVD | 99.98 mol % GaN + | Single | 0.116 | 182 | 5.9 |
| | | layer | | 0.02 mol % Mg | crystal | | | |
| 774 | | Single | MOCVD | 79.90 mol % GaN + | Single | 0.052 | 192 | 4.8 |
| | | layer | | 19.98 mol % InN + | crystal | | | |
| | | | | 0.12 mol % Mg | | | | |
| 775 | | Single | MOCVD | 79.99 mol % GaN + | Single | 0.006 | 197 | 4.6 |
| | | layer | | 19.99 mol % InN + | crystal | | | |
| | | | | 0.01 mol % Si + | | | | |
| | | | | 0.01 mol % Zn | | | | |

TABLE 34

| | | Characteristics of the thin film which formed on the sintered compact which comprises | | | | | | |
|---|---|---|---|---|---|---|---|---|
| | | an aluminum nitride as the main ingredients | | | | | | |
| | | | | | | | Half width of the | |
| | | Formation | | | | | (002) X ray diffraction | Surface |
| | | state and | | | | Electric | rocking curve of the | roughness |
| | Content of | formation | Production | | Crystallized | resistivity of | single crystal thin | of the |
| | the used | position | method | Composition | state | the thin film | film and the | thin film |
| Experiment | AlN | of the | of the | of | of | (Ω · cm) (room | orientated polycrystal | substrate |
| No. | substrate | thin film | thin film | the thin film | the thin film | temperature) | (second) | Ra (nm) |
| 776 | produced | Substrate | Sputter | 99.98 mol % AlN + | Orientated | 104 | 8330 | 1.9 |
| | in | side | | 0.02 mol % Si | polycrystal | | | |
| | Experiment | Surface | MOCVD | 99.98 mol % AlN + | Single | 82 | 88 | 0.94 |
| | No. 49 | layer | | 0.02 mol % Si | crystal | | | |
| 777 | | Substrate | Sputter | 99.98 mol % AlN + | Orientated | 106 | 7920 | 1.6 |
| | | side | | 0.02 mol % Si | polycrystal | | | |
| | | Surface | MOCVD | 99.98 mol % GaN + | Single | 0.013 | 90 | 1.01 |
| | | layer | | 0.02 mol % Si | crystal | | | |
| 778 | | Substrate | Sputter | 99.98 mol % AlN + | Orientated | 99 | 8070 | 1.7 |
| | | side | | 0.02 mol % Si | polycrystal | | | |
| | | Surface | MOCVD | 99.98 mol % GaN + | Single | 0.099 | 87 | 0.92 |
| | | layer | | 0.02 mol % Mg | crystal | | | |
| 779 | | Substrate | Sputter | 99.98 mol % AlN + | Orientated | 107 | 7750 | 1.5 |
| | | side | | 0.02 mol % Si | polycrystal | | | |
| | | Surface | MOCVD | 79.90 mol % GaN + | Single | 0.043 | 95 | 0.87 |
| | | layer | | 19.98 mol % InN + | crystal | | | |
| | | | | 0.12 mol % Mg | | | | |
| 780 | | Substrate | Sputter | 99.98 mol % AlN + | Orientated | 111 | 8130 | 1.6 |
| | | side | | 0.02 mol % Si | polycrystal | | | |
| | | Surface | MOCVD | 79.99 mol % GaN + | Single | 0.005 | 89 | 0.91 |
| | | layer | | 19.99 mol % InN + | crystal | | | |
| | | | | 0.01 mol % Si + | | | | |
| | | | | 0.01 mol % Zn | | | | |
| 781 | | Substrate | MOCVD | 49.99 mol % AlN + | Orientated | 0.84 | 4490 | 1.8 |
| | | side | | 49.99 mol % GaN + | polycrystal | | | |
| | | | | 0.02 mol % Si | | | | |
| | | Surface | MOCVD | 99.98 mol % AlN + | Single | 79 | 82 | 1.00 |
| | | layer | | 0.02 mol % Si | crystal | | | |
| 782 | | Substrate | MOCVD | 49.99 mol % AlN + | Orientated | 0.79 | 4520 | 1.9 |
| | | side | | 49.99 mol % GaN + | polycrystal | | | |
| | | | | 0.02 mol % Si | | | | |
| | | Surface | MOCVD | 99.98 mol % GaN + | Single | 0.010 | 84 | 0.96 |
| | | layer | | 0.02 mol % Si | crystal | | | |
| 783 | | Substrate | MOCVD | 49.99 mol % AlN + | Orientated | 0.92 | 4170 | 1.6 |
| | | side | | 49.99 mol % GaN + | polycrystal | | | |
| | | | | 0.02 mol % Si | | | | |
| | | Surface | MOCVD | 99.98 mol % GaN + | Single | 0.093 | 81 | 0.95 |
| | | layer | | 0.02 mol % Mg | crystal | | | |
| 784 | | Substrate | MOCVD | 49.99 mol % AlN + | Orientated | 0.80 | 4710 | 1.6 |
| | | side | | 49.99 mol % GaN + | polycrystal | | | |
| | | | | 0.02 mol % Si | | | | |
| | | Surface | MOCVD | 79.90 mol % GaN + | Single | 0.036 | 82 | 0.88 |
| | | layer | | 19.98 mol % InN + | crystal | | | |
| | | | | 0.12 mol % Mg | | | | |
| 785 | | Substrate | MOCVD | 49.99 mol % AlN + | Orientated | 0.93 | 4560 | 1.7 |
| | | side | | 49.99 mol % GaN + | polycrystal | | | |
| | | | | 0.02 mol % Si | | | | |
| | | Surface | MOCVD | 79.99 mol % GaN + | Single | 0.005 | 80 | 0.90 |
| | | layer | | 19.99 mol % InN + | crystal | | | |
| | | | | 0.01 mol % Si + | | | | |
| | | | | 0.01 mol % Zn | | | | |

TABLE 35

| | | | | | | Characteristics of the thin film which formed on the substrate which | | | |
|---|---|---|---|---|---|---|---|---|---|
| | | | | | | consists of a sintered compact which comprises an aluminum nitride | | | |
| | | | | | | as the main ingredients | | | |
| | | | | | | | | Thin film which formed | |
| | Characteristics of the sintered compact substrate which | | | | | | | furthermore on the AlN thin film | |
| | comprises an aluminum nitride as the main ingredients | | | | | AlN thin film which formed | | which formed beforehand on the | |
| | Powder compacts | | Characteristics of | | | beforehand on the substrate | | substrate | |
| | Additive | | the sintered compact | | | | Half width of | | Half width of |
| | | Amount | Total | Amount | Optical | | the (002) X ray | | the (002) X ray |
| | | of | amount of | of | trans- | | diffraction | Composition | diffraction |
| Experiment | Additive | addition | oxygen | ALON | missivity | Crystallized | rocking curve | of | rocking curve |
| No. | name | (volume %) *1) | (weight %) | (%) | (%) | state | (second) | the thin film | (second) |
| 786 | none | — | 0.9 | 1.3 | 44 | Amorphous | — | 100 mol % AlN | 91 |
| 787 | | | | | | Polycrystal | — | 100 mol % AlN | 93 |
| 788 | | | | | | Orientated | 6910 | 100 mol % AlN | 87 |
| | | | | | | polycrystal | | | |
| 789 | | | | | | Single crystal | 189 | 100 mol % AlN | 99 |
| 790 | Al₂O₃ | 0.1 | 0.9 | 1.4 | 37 | Orientated | 7270 | 100 mol % AlN | 89 |
| | | | | | | polycrystal | | | |
| 791 | Al₂O₃ | 3.0 | 2.6 | 6.9 | 21 | Orientated | 7130 | 100 mol % AlN | 95 |
| | | | | | | polycrystal | | | |
| 792 | Al₂O₃ | 7.0 | 4.8 | 10 | 7.4 | Amorphous | — | 100 mol % AlN | 92 |
| 793 | | | | | | Polycrystal | — | 100 mol % AlN | 96 |
| 794 | | | | | | Orientated | 7190 | 100 mol % AlN | 88 |
| | | | | | | polycrystal | | | |
| 795 | | | | | | Single crystal | 235 | 100 mol % AlN | 104 |
| 796 | Al₂O₃ | 12.0 | 7.7 | 17 | 3.9 | Orientated | 7090 | 100 mol % AlN | 92 |
| | | | | | | polycrystal | | | |
| 797 | Al₂O₃ | 24.0 | 14.1 | 34 | 0.7 | Orientated | 7170 | 100 mol % AlN | 96 |
| | | | | | | polycrystal | | | |
| 798 | Al₂O₃ | 36.0 | 20.7 | 47 | 0.0 | Orientated | 7440 | 100 mol % AlN | 95 |
| | | | | | | polycrystal | | | |
| 799 | Al₂O₃ | 50.0 | 26.2 | 59 | 0.0 | Amorphous | — | 100 mol % AlN | 118 |
| 800 | | | | | | Polycrystal | — | 100 mol % AlN | 122 |
| 801 | | | | | | Orientated | 7220 | 100 mol % AlN | 109 |
| | | | | | | polycrystal | | | |
| 802 | Al₂O₃ | 56.0 | 28.6 | 77 | 0.0 | AlN thin film | — | 100 mol % AlN | Polycrystal |
| | | | | | | is not formed | | | (Single crystal |
| | | | | | | beforehand | | | is not |
| | | | | | | | | | formed) |
| 803 | | | | | | Orientated | 7380 | 100 mol % AlN | 127 |
| | | | | | | polycrystal | | | |
| 804 | Al₂O₃ | 7.0 | 5.8 | 0.0 | 34 | Orientated | 7020 | 100 mol % AlN | 86 |
| | Y₂O₃ | 3.3 | | | | polycrystal | | | |
| 805 | Al₂O₃ | 12.0 | 8.6 | 0.0 | 23 | Orientated | 7150 | 100 mol % AlN | 89 |
| | Y₂O₃ | 3.3 | | | | polycrystal | | | |
| 806 | Al₂O₃ | 24.0 | 14.6 | 29 | 8.1 | Orientated | 6960 | 100 mol % AlN | 85 |
| | Er₂O₃ | 8.0 | | | | polycrystal | | | |
| 807 | Al₂O₃ | 36.0 | 22.4 | 33 | 8.5 | Orientated | 7250 | 100 mol % AlN | 93 |
| | Y₂O₃ | 10.0 | | | | polycrystal | | | |

*1) Amount of the additive is based on oxide conversion.

TABLE 36

| | | | | | | Characteristics of the thin film which formed on the substrate which | | | |
|---|---|---|---|---|---|---|---|---|---|
| | | | | | | consists of a sintered compact which comprises an aluminum nitride | | | |
| | | | | | | as the main ingredients | | | |
| | | | | | | | | Thin film which formed | |
| | Characteristics of the sintered compact substrate which | | | | | | | furthermore on the AlN thin | |
| | comprises an aluminum nitride as the main ingredients | | | | | AlN thin film which formed | | film which formed beforehand | |
| | Powder compacts | | Characteristics of | | | beforehand on the substrate | | on the substrate | |
| | Additive | | the sintered compact | | | | Half width of | | Half width of |
| | | Amount of | Total | Optical | | | the (002) X ray | | the (002) X ray |
| Exper- | | addition | amount of | trans- | Thermal | | diffraction | Composition | diffraction |
| iment | Additive | (volume | oxygen | missivity | conductivity | | rocking curve | of | rocking curve |
| No. | name | %) *1) | (weight %) | (%) | (W/mK) | Crystallized state | (second) | the thin film | (second) |
| 808 | CaCO₃ | 0.5 | 0.9 | 46 | 177 | Orientated polycrystal | 6810 | 100 mol % AlN | 84 |
| 809 | CaCO₃ | 7.5 | 2.6 | 4.6 | 131 | Orientated polycrystal | 7230 | 100 mol % AlN | 93 |
| 810 | CaCO₃ | 25 | 7.9 | 2.5 | 101 | Orientated polycrystal | 7260 | 100 mol % AlN | 92 |
| 811 | CaCO₃ | 45 | 14.6 | 0.4 | 59 | Orientated polycrystal | 7370 | 100 mol % AlN | 101 |
| 812 | CaCO₃ | 54 | 16.4 | 0.0 | 44 | Amorphous | — | 100 mol % AlN | 122 |
| 813 | | | | | | Polycrystal | — | 100 mol % AlN | 127 |
| 814 | | | | | | Orientated polycrystal | 7130 | 100 mol % AlN | 114 |
| 815 | SrCO₃ | 3.0 | 1.6 | 13 | 134 | Orientated polycrystal | 7100 | 100 mol % GaN | 89 |
| 816 | BaCO₃ | 30 | 5.7 | 4.0 | 112 | Orientated polycrystal | 7080 | 100 mol % AlN | 90 |
| 817 | BeO | 40 | 24.5 | 0.0 | 109 | Orientated polycrystal | 6760 | 100 mol % AlN | 85 |
| 818 | MgO | 5.0 | 3.2 | 7.1 | 58 | Orientated polycrystal | 7040 | 100 mol % InN | 90 |
| 819 | Y₂O₃ | 0.1 | 0.8 | 52 | 130 | Orientated polycrystal | 6720 | 100 mol % AlN | 83 |
| 820 | Y₂O₃ | 25 | 7.5 | 9.7 | 172 | Amorphous | — | 100 mol % AlN | 89 |
| 821 | | | | | | Polycrystal | — | 100 mol % AlN | 95 |
| 822 | | | | | | Orientated polycrystal | 6960 | 100 mol % AlN | 85 |
| 823 | | | | | | Single crystal | 188 | 100 mol % AlN | 97 |
| 824 | Y₂O₃ | 45 | 13.1 | 0.5 | 124 | Orientated polycrystal | 7430 | 100 mol % GaN | 97 |
| 825 | Y₂O₃ | 55 | 15.2 | 0.0 | 102 | Amorphous | — | 100 mol % AlN | 116 |
| 826 | | | | | | Polycrystal | — | 100 mol % AlN | 119 |
| 827 | | | | | | Orientated polycrystal | 7170 | 100 mol % AlN | 99 |
| 828 | Y₂O₃ | 72 | 17.8 | 0.0 | 54 | AlN thin film is not | — | 100 mol % AlN | Polycrystal |
| | | | | | | formed beforehand | | | (Single crystal |
| | | | | | | | | | is not formed) |
| 829 | | | | | | Orientated polycrystal | 7350 | 100 mol % AlN | 124 |
| 830 | CaCO₃ | 35 | 15.0 | 0.0 | 152 | Orientated polycrystal | 6920 | 100 mol % AlN | 88 |
| | Y₂O₃ | 10 | | | | | | | |
| 831 | BaCO₃ | 35 | 9.3 | 17 | 113 | Orientated polycrystal | 7550 | 100 mol % AlN | 97 |
| | Y₂O₃ | 10 | | | | | | | |
| 832 | Sm₂O₃ | 40 | 9.8 | 0.4 | 94 | Orientated polycrystal | 7290 | 50 mol % AlN + | 91 |
| | | | | | | | | 50 mol % GaN | |
| 833 | Gd₂O₃ | 20 | 5.8 | 7.8 | 120 | Orientated polycrystal | 7220 | 100 mol % AlN | 92 |
| 834 | Dy₂O₃ | 20 | 5.7 | 8.5 | 134 | Orientated polycrystal | 7380 | 100 mol % AlN | 94 |
| 835 | Ho₂O₃ | 40 | 9.6 | 0.4 | 102 | Orientated polycrystal | 7110 | 100 mol % AlN | 90 |
| 836 | Er₂O₃ | 20 | 5.6 | 10.5 | 147 | Orientated polycrystal | 6880 | 100 mol % AlN | 86 |
| 837 | Er₂O₃ | 45 | 9.6 | 0.7 | 106 | Orientated polycrystal | 6940 | 100 mol % AlN | 87 |
| 838 | CaCO₃ | 43 | 14.8 | 0.0 | 66 | Orientated polycrystal | 7030 | 100 mol % GaN | 89 |
| | Er₂O₃ | 2.0 | | | | | | | |
| 839 | Yb₂O₃ | 30 | 7.3 | 3.6 | 105 | Orientated polycrystal | 6990 | 100 mol % AlN | 89 |

*1) Amount of the additive is based on oxide conversion.

TABLE 37

| | | | | | Characteristics of the thin film which formed on the | | | |
|---|---|---|---|---|---|---|---|---|
| | | | | | substrate which consists of a sintered compact which comprises | | | |
| | Characteristics of the sintered compact substrate | | | | an aluminum nitride as the main ingredients | | | |
| | which comprises an aluminum nitride as the main | | | | | | Thin film which formed | |
| | ingredients | | | | | | furthermore on the AlN | |
| | | | Characteristics | | AlN thin film which formed | | thin film which formed | |
| | | | of | | beforehand on the substrate | | beforehand on the substrate | |
| | Powder compacts | | the sintered compact | | | Half width of | | Half width of |
| | Additive | | Total | | | the (002) X ray | | the (002) X ray |
| Exper- | | Amount of | amount of | Optical | | diffraction | Composition | diffraction |
| iment | Additive | addition | oxygen | transmissivity | Crystallized | rocking curve | of | rocking curve |
| No. | name | (volume %) *1) | (weight %) | (%) | state | (second) | the thin film | (second) |
| 840 | Li₂CO₃ | 2.0 | 1.6 | 6.1 | Orientated | 6860 | 100 mol % AlN | 86 |
| | | | | | polycrystal | | | |
| 841 | Li₂CO₃ | 15 | 6.4 | 0.0 | Orientated | 7080 | 100 mol % AlN | 88 |
| | | | | | polycrystal | | | |
| 842 | Li₂CO₃ | 25 | 10.7 | 0.0 | Amorphous | — | 100 mol % AlN | 126 |
| 843 | | | | | Polycrystal | — | 100 mol % AlN | 126 |
| 844 | | | | | Orientated | 7190 | 100 mol % AlN | 118 |
| | | | | | polycrystal | | | |
| 845 | Li₂CO₃ | 2.0 | 2.5 | 14 | Orientated | 6900 | 100 mol % AlN | 87 |
| | Y₂O₃ | 3.3 | | | polycrystal | | | |
| 846 | Li₂CO₃ | 15 | 7.0 | 0.0 | Orientated | 7060 | 100 mol % AlN | 90 |
| | Er₂O₃ | 3.6 | | | polycrystal | | | |
| 847 | Li₂CO₃ | 15 | 7.9 | 0.0 | Orientated | 6940 | 100 mol % AlN | 89 |
| | Er₂O₃ | 8.0 | | | polycrystal | | | |
| | CaCO₃ | 0.5 | | | | | | |
| 848 | Na₂CO₃ | 8.0 | 2.4 | 0.4 | Orientated | 7530 | 100 mol % AlN | 97 |
| | | | | | polycrystal | | | |
| 849 | K₂CO₃ | 4.0 | 1.5 | 2.2 | Orientated | 7410 | 100 mol % AlN | 94 |
| | | | | | polycrystal | | | |
| 850 | Si | 16 | 0.9 | 0.0 | Orientated | 7230 | 100 mol % AlN | 90 |
| | | | | | polycrystal | | | |
| 851 | Si | 25 | 1.0 | 0.0 | Amorphous | — | 100 mol % AlN | 124 |
| 852 | | | | | Polycrystal | — | 100 mol % AlN | 128 |
| 853 | | | | | Orientated | 6810 | 100 mol % AlN | 106 |
| | | | | | polycrystal | | | |
| 854 | Si | 16 | 1.8 | 0.0 | Orientated | 6770 | 100 mol % AlN | 85 |
| | Er₂O₃ | 3.6 | | | polycrystal | | | |
| 855 | Si₃N₄ | 4.0 | 1.0 | 0.0 | Orientated | 6820 | 100 mol % AlN | 87 |
| | | | | | polycrystal | | | |
| 856 | SiC | 8.0 | 1.0 | 0.0 | Orientated | 7510 | 100 mol % AlN | 96 |
| | | | | | polycrystal | | | |
| 857 | SiO₂ | 2.5 | 2.1 | 6.5 | Amorphous | — | 100 mol % AlN | 89 |
| 858 | | | | | Polycrystal | — | 100 mol % AlN | 96 |
| 859 | | | | | Orientated | 6790 | 100 mol % AlN | 85 |
| | | | | | polycrystal | | | |
| 860 | | | | | Single crystal | 187 | 100 mol % AlN | 102 |
| 861 | SiO₂ | 50 | 24.9 | 0.0 | AlN thin film | — | 100 mol % AlN | Polycrystal |
| | | | | | is not formed | | | (Single crystal |
| | | | | | beforehand | | | is not formed) |
| 862 | | | | | Amorphous | — | 100 mol % AlN | 125 |
| 863 | | | | | Polycrystal | — | 100 mol % AlN | 129 |
| 864 | | | | | Orientated | 6870 | 100 mol % AlN | 109 |
| | | | | | polycrystal | | | |

*1) Amount of the additive is based on oxide conversion.

TABLE 38

| | | | | | Characteristics of the thin film which formed on the substrate which | | | |
|---|---|---|---|---|---|---|---|---|
| | | | | | consists of a sintered compact which comprises | | | |
| | | | | | an aluminum nitride as the main ingredients | | | |
| | Characteristics of the sintered compact substrate | | | | | | Thin film which formed | |
| | which comprises an aluminum nitride as the | | | | | | furthermore on the AlN thin | |
| | main ingredients | | | | AlN thin film which formed | | film which formed | |
| | Powder compacts | | Characteristics of | | beforehand on the substrate | | beforehand on the substrate | |
| | Additive | | the sintered compact | | | Half width of | | Half width of |
| | | Amount | Total | | | the (002) X ray | | the (002) X ray |
| | | of | amount of | Optical | | diffraction | Composition | diffraction |
| Experiment | Additive | addition | oxygen | transmissivity | | rocking curve | of | rocking curve |
| No. | name | (volume %) *1) | (weight %) | (%) | Crystallized state | (second) | the thin film | (second) |
| 865 | | | | | Amorphous | — | 100 mol % AlN | 91 |
| 866 | | | | | Polycrystal | — | 100 mol % AlN | 92 |
| 867 | | | | | Orientated polycrystal | 6750 | 100 mol % AlN | 86 |
| 868 | | | | | Single crystal | 145 | 100 mol % AlN | 98 |
| 869 | MoO₃ | 2.0 | 0.8 | 6.9 | Orientated polycrystal | 6860 | 100 mol % AlN | 87 |
| 870 | MoO₃ | 4.0 | 0.8 | 3.3 | Orientated polycrystal | 6750 | 100 mol % AlN | 85 |
| 871 | Mo | 8.0 | 0.8 | 0.7 | Orientated polycrystal | 7070 | 100 mol % AlN | 89 |
| 872 | Mo | 12 | 0.8 | 0.6 | Orientated polycrystal | 6950 | 100 mol % GaN | 88 |
| 873 | Mo | 24 | 0.9 | 0.0 | Orientated polycrystal | 7030 | 100 mol % AlN | 89 |
| 874 | Mo | 42 | 0.9 | 0.0 | Orientated polycrystal | 7280 | 100 mol % AlN | 93 |
| 875 | Mo | 55 | 0.8 | 0.0 | Amorphous | — | 100 mol % AlN | 96 |
| 876 | | | | | Polycrystal | — | 100 mol % AlN | 97 |
| 877 | | | | | Orientated polycrystal | 7110 | 100 mol % AlN | 88 |
| 878 | WO₃ | 0.2 | 0.8 | 24 | Orientated polycrystal | 6670 | 100 mol % AlN | 83 |
| 879 | W | 15 | 0.8 | 0.8 | Orientated polycrystal | 7040 | 100 mol % AlN | 89 |
| 880 | W | 30 | 0.8 | 0.0 | Orientated polycrystal | 6970 | 100 mol % GaN | 89 |
| 881 | W | 55 | 0.7 | 0.0 | Amorphous | — | 100 mol % AlN | 104 |
| 882 | | | | | Polycrystal | — | 100 mol % AlN | 116 |
| 883 | | | | | Orientated polycrystal | 7090 | 100 mol % AlN | 97 |
| 884 | W | 75 | 0.6 | 0.0 | AlN thin film is not | — | 100 mol % AlN | Polycrystal |
| | | | | | formed beforehand | | | (Single crystal |
| | | | | | | | | is not formed) |
| 885 | | | | | Amorphous | — | 100 mol % AlN | 117 |
| 886 | | | | | Polycrystal | — | 100 mol % AlN | 123 |
| 887 | | | | | Orientated polycrystal | 7150 | 100 mol % AlN | 104 |
| 888 | V₂O₆ | 4.0 | 0.9 | 2.4 | Orientated polycrystal | 7010 | 100 mol % AlN | 89 |
| 889 | V | 16 | 0.9 | 0.6 | Orientated polycrystal | 7240 | 100 mol % InN | 92 |
| 890 | V | 32 | 0.8 | 0.0 | Orientated polycrystal | 7380 | 100 mol % AlN | 94 |
| 891 | TiO₂ | 2.0 | 0.8 | 7.4 | Orientated polycrystal | 7170 | 100 mol % AlN | 91 |
| 892 | TiO₂ | 12 | 0.9 | 0.0 | Orientated polycrystal | 7160 | 50 mol % AlN + | 90 |
| | | | | | | | 50 mol % GaN | |
| 893 | Nb₂O₅ | 7.5 | 0.8 | 0.8 | Orientated polycrystal | 6920 | 100 mol % AlN | 88 |
| 894 | Nb | 15 | 0.8 | 0.4 | Orientated polycrystal | 7390 | 50 mol % GaN + | 94 |
| | | | | | | | 50 mol % InN | |
| 895 | Nb | 40 | 0.8 | 0.0 | Orientated polycrystal | 7370 | 100 mol % AlN | 93 |
| 896 | Ta₂O₅ | 7.0 | 0.8 | 0.5 | Orientated polycrystal | 7340 | 100 mol % AlN | 93 |
| 897 | Ta | 12 | 0.8 | 0.0 | Orientated polycrystal | 7220 | 100 mol % AlN | 91 |
| 898 | Carbon | 1.5 | 0.3 | 7.7 | Orientated polycrystal | 6890 | 100 mol % GaN | 87 |
| 899 | Carbon | 7.0 | 0.07 | 0.4 | Orientated polycrystal | 7040 | 100 mol % AlN | 89 |
| 900 | Carbon | 15 | 0.02 | 0.0 | Orientated polycrystal | 7430 | 100 mol % AlN | 96 |

*1) Amount of the additive is based on element conversion.

TABLE 39

| | | | | | Characteristic of the thin film which formed on the substrate | | | |
|---|---|---|---|---|---|---|---|---|
| | | | | | which consists of a sintered compact which comprises | | | |
| | | | | | an aluminum nitride as the main ingredients | | | |
| | Characteristics of the sintered compact substrate | | | | | | Thin film which formed | |
| | which comprises an aluminum nitride as the | | | | | | furthermore on the AlN thin | |
| | main ingredients | | | | AlN thin film which formed | | film which formed | |
| | Powder compacts | | Characteristics of | | beforehand on the substrate | | beforehand on the substrate | |
| | Additive | | the sintered compact | | | Half width of | | Half width of |
| | | Amount | Total | | | the (002) X ray | | the (002) X ray |
| Exper- | | of | amount of | Optical | | diffraction | Composition | diffraction |
| iment | Additive | addition | oxygen | transmissivity | Crystallized | rocking curve | of | rocking curve |
| No. | name | (volume %) *1) | (weight %) | (%) | state | (second) | the thin film | (second) |
| 901 | MoO₃ | 2.0 | 1.9 | 17 | Amorphous | — | 100 mol % AlN | 89 |
| 902 | | | | | Polycrystal | — | 100 mol % AlN | 91 |
| 903 | Y₂O₃ | 3.3 | | | Orientated | 6640 | 100 mol % AlN | 82 |
| | | | | | polycrystal | | | |
| 904 | | | | | Single crystal | 138 | 100 mol % AlN | 93 |
| 905 | MoO₃ | 4.0 | 2.0 | 11 | Orientated | 6820 | 100 mol % AlN | 85 |
| | Er₂O₃ | 3.6 | | | polycrystal | | | |
| 906 | Mo | 8.0 | 1.2 | 3.0 | Orientated | 6790 | 100 mol % AlN | 85 |
| | CaCO₃ | 1.0 | | | polycrystal | | | |
| 907 | Mo | 24 | 1.2 | 0.0 | Orientated | 6900 | 100 mol % AlN | 88 |
| | Y₂O₃ | 3.3 | | | polycrystal | | | |
| | CaCO₃ | 0.5 | | | | | | |
| 908 | Mo | 42 | 0.9 | 0.0 | Amorphous | — | 100 mol % AlN | 95 |
| 909 | Er₂O₃ | 3.6 | | | Polycrystal | — | 100 mol % AlN | 97 |
| 910 | CaCO₃ | 0.5 | | | Orientated | 7110 | 100 mol % AlN | 92 |
| | | | | | polycrystal | | | |
| 911 | | | | | Single crystal | 214 | 100 mol % AlN | 102 |
| 912 | W | 15 | 1.1 | 2.1 | Orientated | 7040 | 100 mol % AlN | 89 |
| | Er₂O₃ | 3.6 | | | polycrystal | | | |
| 913 | W | 60 | 1.2 | 0.0 | AlN thin film | — | 100 mol % AlN | Polycrystal |
| | | | | | is not formed | | | (Single crystal |
| | | | | | beforehand | | | is not formed) |
| 914 | Er₂O₃ | 3.6 | | | Amorphous | — | 100 mol % AlN | 109 |
| 915 | | | | | Polycrystal | — | 100 mol % AlN | 121 |
| 916 | | | | | Orientated | 7120 | 100 mol % AlN | 103 |
| | | | | | polycrystal | | | |
| 917 | W | 30 | 0.7 | 0.0 | Orientated | 7050 | 100 mol % GaN | 90 |
| | Y₂O₃ | 3.3 | | | polycrystal | | | |
| | CaCO₃ | 0.5 | | | | | | |
| 918 | V₂O₅ | 4.0 | 2.1 | 12 | Orientated | 6870 | 100 mol % AlN | 87 |
| | Er₂O₃ | 3.6 | | | polycrystal | | | |
| 919 | Carbon | 7.0 | 0.03 | 4.4 | Orientated | 6950 | 100 mol % AlN | 89 |
| | Y₂O₃ | 3.3 | | | polycrystal | | | |

*1) Amount of the additive is based on element conversion. However, amount of addition of an alkaline-earth metal and a rare earth metal ingredient is based on oxide conversion.

TABLE 40

| | | | | | Characteristic of the thin film which formed on the substrate | | | |
|---|---|---|---|---|---|---|---|---|
| | | | | | which consists of a sintered compact which comprises | | | |
| | | | | | an aluminum nitride as the main ingredients | | | |
| | Characteristics of the sintered compact substrate | | | | | | Thin film which formed | |
| | which comprises an aluminum nitride as the | | | | | | furthermore on the AlN thin | |
| | main ingredients | | | | AlN thin film which formed | | film which formed | |
| | | | Characteristics of | | beforehand on the substrate | | beforehand on the substrate | |
| | Powder compacts | | the sintered compact | | | Half width of | | Half width of |
| | Additive | | Total | | | the (002) X ray | | the (002) X ray |
| | | Amount of | amount of | Optical | | diffraction | Composition | diffraction |
| Experiment | Additive | addition | oxygen | transmissivity | | rocking curve | of | rocking curve |
| No. | name | (volume %) *1) | (weight %) | (%) | Crystallized state | (second) | the thin film | (second) |
| 920 | Fe | 0.8 | 0.8 | 3.6 | Amorphous | — | 100 mol % AlN | 91 |
| 921 | | | | | Polycrystal | — | 100 mol % AlN | 93 |
| 922 | | | | | Orientated polycrystal | 6840 | 100 mol % AlN | 86 |
| 923 | | | | | Single crystal | 156 | 100 mol % AlN | 96 |
| 924 | Fe | 8.0 | 0.8 | 0.7 | Orientated polycrystal | 6890 | 100 mol % AlN | 88 |
| 925 | Fe | 16 | 0.7 | 0.4 | Orientated polycrystal | 7230 | 100 mol % GaN | 91 |
| 926 | Fe | 32 | 0.9 | 0.0 | Orientated polycrystal | 7360 | 100 mol % AlN | 93 |
| 927 | Fe | 55 | 1.0 | 0.0 | Amorphous | — | 100 mol % AlN | 115 |
| 928 | | | | | Polycrystal | — | 100 mol % AlN | 119 |
| 929 | | | | | Orientated polycrystal | 7170 | 100 mol % AlN | 97 |
| 930 | Fe | 72 | 1.1 | 0.0 | AlN thin film is | — | 100 mol % AlN | Polycrystal |
| | | | | | not formed | | | (Single crystal |
| | | | | | beforehand | | | is not formed) |
| 931 | | | | | Orientated polycrystal | 7410 | 100 mol % AlN | 119 |
| 932 | Fe | 8.0 | 1.7 | 4.4 | Orientated polycrystal | 6720 | 100 mol % AlN | 85 |
| | Y₂O₃ | 3.3 | | | | | | |
| 933 | Fe | 16 | 1.4 | 1.5 | Orientated polycrystal | 6690 | 100 mol % GaN | 85 |
| | Er₂O₃ | 3.6 | | | | | | |
| 934 | Fe | 32 | 1.2 | 0.0 | Orientated polycrystal | 7260 | 100 mol % AlN | 91 |
| | Y₂O₃ | 3.3 | | | | | | |
| | CaCO₃ | 0.5 | | | | | | |
| 935 | NiO | 3.5 | 0.9 | 0.7 | Orientated polycrystal | 7030 | 100 mol % AlN | 89 |
| 936 | Ni | 42 | 0.8 | 0.0 | Orientated polycrystal | 7290 | 100 mol % AlN | 94 |
| 937 | Ni | 42 | 1.7 | 0.0 | Orientated polycrystal | 7330 | 100 mol % AlN | 97 |
| | Y₂O₃ | 3.3 | | | | | | |
| 938 | Cr | 0.8 | 0.8 | 2.9 | Orientated polycrystal | 6870 | 100 mol % AlN | 88 |
| 939 | Mn | 5.0 | 0.8 | 0.6 | Orientated polycrystal | 6840 | 100 mol % AlN | 87 |
| 940 | Zr | 15 | 0.8 | 0.0 | Orientated polycrystal | 7380 | 50 mol % AlN + | 94 |
| | | | | | | | 50 mol % GaN | |
| 941 | Hf | 7.5 | 0.8 | 0.7 | Orientated polycrystal | 7150 | 100 mol % AlN | 90 |
| 942 | CoO | 0.8 | 0.9 | 4.4 | Orientated polycrystal | 6830 | 100 mol % AlN | 87 |
| 943 | CuO | 12 | 1.0 | 0.0 | Orientated polycrystal | 7420 | 100 mol % InN | 94 |
| 944 | Zn | 3.0 | 0.8 | 0.4 | Orientated polycrystal | 6760 | 100 mol % AlN | 86 |

*1) Weight % by element conversion has shown the quantity of the additive. However, volume % by oxide conversion shows the amount of addition of the alkaline-earth metal and rare earth metal ingredient.

TABLE 41

| | | | Characteristics of the thin film which formed on the substrate which consists of | | | | |
|---|---|---|---|---|---|---|---|
| | | | various sintered compacts | | | | |
| | Characteristics of the | | AlN thin film which formed beforehand | | Thin film which formed furthermore on the AIN thin | | |
| | sintered compact substrate | | on the various substrates | | film which formed beforehand on the various substrates | | |
| | | Degree of | | Half width of | | | Half width of |
| | | surface | | the (002) X ray | Thickness | | the (002) X ray |
| Experi- | | smoothness | | diffraction | of the | | diffraction |
| ment | Main | Ra | | rocking curve | thin film | Composition of | rocking curve |
| No. | ingredient | (nm) | Crystallized state | (second) | (μm) | the thin film | (second) |
| 945 | Silicon carbide | 6.8 | (not formed) | — | 3.0 | 100 mol % AlN | 255 |
| 946 947 948 949 | 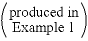 | | (not formed) (not formed) Amorphous Polycrystal | ———— | 3.0 3.0 3.0 3.0 | 100 mol % GaN 100 mol % InN 100 mol % AlN 100 mol % AlN | 279 283 169 186 |
| 950 | | | Orientated polycrystal | 9640 | 3.0 | 100 mol % AlN | 140 |
| 951 | | | Single crystal | 262 | 3.0 | 100 mol % AlN | 192 |
| 952 | | | Orientated polycrystal | 9900 | 3.0 | 100 mol % GaN | 147 |
| 953 | | | Orientated polycrystal | 9780 | 3.0 | 100 mol % InN | 144 |
| 954 | | | (not formed) | — | 3.0 | 50 mol % AlN + 50 mol % GaN | 269 |
| 955 | | | Orientated polycrystal | 9540 | 3.0 | 50 mol % AlN + 50 mol % GaN | 139 |
| 956 | Silicon nitride | 15 | (not formed) | — | 3.0 | 100 mol % AlN | 493 |
| 957 958 959 960 | 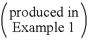 | | (not formed) (not formed) Amorphous Orientated polycrystal | ———10880 | 3.0 3.0 3.0 3.0 | 100 mol % GaN 100 mol % InN 100 mol % AlN 100 mol % AlN | 508 647 188 163 |
| 961 | | | Orientated polycrystal | 11830 | 3.0 | 100 mol % GaN | 166 |
| 962 | | | Orientated polycrystal | 12070 | 3.0 | 100 mol % InN | 167 |
| 963 | Aluminum | 11 | (not formed) | — | 3.0 | 100 mol % AlN | 389 |
| 964 | oxide | | (not formed) | — | 3.0 | 100 mol % GaN | 421 |
| 965 966 967 968 | 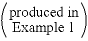 | | (not formed) Amorphous Polycrystal Orientated polycrystal | ———10490 | 3.0 3.0 3.0 3.0 | 100 mol % InN 100 mol % AlN 100 mol % AlN 100 mol % AlN | 426 169 174 155 |
| 969 | | | Single crystal | 344 | 3.0 | 100 mol % AlN | 195 |
| 970 | | | Orientated polycrystal | 10720 | 3.0 | 100 mol % GaN | 161 |
| 971 | | | Orientated polycrystal | 11310 | 3.0 | 100 mol % InN | 163 |
| 972 | | | (not formed) | — | 3.0 | 50 mol % AlN + 50 mol % GaN | 377 |
| 973 | | | Orientated polycrystal | 10550 | 3.0 | 50 mol % AlN + 50 mol % GaN | 159 |
| 974 | Zinc oxide | 8.8 | (not formed) | — | 3.0 | 100 mol % AlN | 258 |
| 975 976 977 978 | 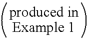 | | (not formed) (not formed) Amorphous Polycrystal | ———— | 3.0 3.0 3.0 3.0 | 100 mol % GaN 100 mol % InN 100 mol % AlN 100 mol % AlN | 291 285 182 189 |
| 979 | | | Orientated polycrystal | 9450 | 3.0 | 100 mol % AlN | 139 |
| 980 | | | Single crystal | 261 | 3.0 | 100 mol % GaN | 196 |
| 981 | | | Orientated polycrystal | 9800 | 3.0 | 100 mol % AlN | 144 |
| 982 | | | Orientated polycrystal | 9740 | 3.0 | 100 mol % InN | 142 |
| 983 | | | (not formed) | — | 3.0 | 50 mol % AlN + 50 mol % GaN | 275 |
| 984 | | | Orientated polycrystal | 9510 | 3.0 | 50 mol % AlN + 50 mol % GaN | 136 |
| 985 | Beryllium | | (not formed) | — | 3.0 | 100 mol % AlN | 268 |
| 986 | oxide | | (not formed) | — | 3.0 | 100 mol % GaN | 284 |
| 987 988 989 990 | 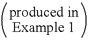 | | (not formed) Orientated polycrystal Single crystal Orientated polycrystal | —9520 271 9810 | 3.0 3.0 3.0 3.0 | 100 mol % InN 100 mol % AlN 100 mol % AlN 100 mol % GaN | 290 140 202 146 |
| 991 | | | Orientated polycrystal | 9690 | 3.0 | 100 mol % InN | 143 |
| 992 | | | (not formed) | — | 3.0 | 50 mol % AlN + 50 mol % GaN | 275 |
| 993 | | | Orientated polycrystal | 9580 | 3.0 | 50 mol % AlN + 50 mol % GaN | 137 |

TABLE 42

| | | | Characteristics of the thin film which formed on the substrate which consists of various sintered compacts | | | | | |
|---|---|---|---|---|---|---|---|---|
| | | | | | | Thin film which formed furthermore on | | |
| | Characteristics of the | | Thin film which formed beforehand on | | | the thin film which formed beforehand on | | |
| | sintered compact substrate | | the various substrates | | | the various substrates | | |
| | | Degree of | | | Half width of | | | Half width of |
| | | surface | | | the (002) X ray | Thickness | | the (002) X ray |
| Experi- | | smoothness | Composition | | diffraction | of the | Composition | diffraction |
| ment | Main | Ra | of the | | rocking curve | thin film | of the | rocking curve |
| No. | ingredient | (nm) | thin film | Crystallized state | (second) | (μm) | thin film | (second) |
| 994 | Silicon | 6.8 | 100 mol % GaN | Amorphous | — | 3.0 | 100 mol % AlN | 165 |
| 995 | carbide | | 100 mol % GaN | Polycrystal | — | 3.0 | 100 mol % AlN | 172 |
| 996 997 998 | 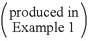 | | 100 mol % GaN 100 mol % GaN 100 mol % GaN 100 mol % GaN | Orientated polycrystal Single crystal Orientated polycrystal Orientated polycrystal | 9660 277 9790 9650 | 3.0 3.0 3.0 3.0 | 100 mol % AlN 100 mol % AlN 100 mol % GaN 100 mol % InN | 142 179 144 141 |
| 1000 | | | 100 mol % GaN | Orientated polycrystal | 9470 | 3.0 | 50 mol % AIN + | 137 |
| | | | | | | | 50 mol % GaN | |
| 1001 | | | 100 mol % InN | Orientated polycrystal | 9830 | 3.0 | 100 mol % GaN | 146 |
| 1002 | | | 100 mol % InN | Single crystal | 283 | 3.0 | 100 mol % GaN | 189 |
| 1003 | Silicon | 15 | 100 mol % GaN | Amorphous | — | 3.0 | 100 mol % AlN | 170 |
| 1004 | nitride | | 100 mol % GaN | Polycrystal | — | 3.0 | 100 mol % AlN | 169 |
| 1005 1006 1007 1008 | 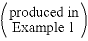 | | 100 mol % GaN 100 mol % GaN 100 mol % GaN 100 mol % InN | Orientated polycrystal Single crystal Orientated polycrystal Orientated polycrystal | 11640 469 10790 10970 | 3.0 3.0 3.0 3.0 | 100 mol % AlN 100 mol % AlN 100 mol % GaN 100 mol % InN | 167 189 161 163 |
| 1009 | | | 100 mol % InN | Single crystal | 526 | 3.0 | 100 mol % InN | 185 |
| 1010 | Aluminum | 11 | 100 mol % GaN | Amorphous | — | 3.0 | 100 mol % AlN | 172 |
| 1011 | oxide | | 100 mol % GaN | Polycrystal | — | 3.0 | 100 mol % AlN | 170 |
| 1012 1013 1014 1015 | 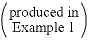 | | 100 mol % GaN 100 mol % GaN 100 mol % GaN 100 mol % GaN | Orientated polycrystal Single crystal Orientated polycrystal Orientated polycrystal | 10450 362 11060 10630 | 3.0 3.0 3.0 3.0 | 100 mol % AlN 100 mol % AlN 100 mol % GaN 100 mol % InN | 154 190 164 159 |
| 1016 | | | 100 mol % GaN | Orientated polycrystal | 11410 | 3.0 | 50 mol % GaN + | 165 |
| | | | | | | | 50 mol % InN | |
| 1017 | | | 100 mol % InN | Orientated polycrystal | 10650 | 3.0 | 100 mol % AlN | 160 |
| 1018 | | | 100 mol % InN | Single crystal | 358 | 3.0 | 100 mol % AlN | 187 |
| 1019 | Zinc oxide | 8.8 | 100 mol % GaN | Amorphous | — | 3.0 | 100 mol % AlN | 157 |
| 1020 1021 1022 1023 | 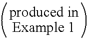 | | 100 mol % GaN 100 mol % GaN 100 mol % GaN 100 mol % GaN | Polycrystal Orientated polycrystal Single crystal Orientated polycrystal | —9490 267 9520 | 3.0 3.0 3.0 3.0 | 100 mol % AlN 100 mol % AlN 100 mol % AlN 100 mol % GaN | 167 137 192 136 |
| 1024 | | | 100 mol % GaN | Orientated polycrystal | 9540 | 3.0 | 100 mol % InN | 140 |
| 1025 | | | 100 mol % GaN | Orientated polycrystal | 9830 | 3.0 | 50 mol % GaN + | 146 |
| | | | | | | | 50 mol % InN | |
| 1026 | | | 100 mol % InN | Orientated polycrystal | 9730 | 3.0 | 100 mol % AlN | 142 |
| 1027 | | | 100 mol % InN | Single crystal | 274 | 3.0 | 100 mol % AlN | 182 |
| 1028 | Beryllium | 9.4 | 100 mol % GaN | Amorphous | — | 3.0 | 100 mol % AlN | 160 |
| 1029 | oxide | | 100 mol % GaN | Polycrystal | — | 3.0 | 100 mol % AlN | 171 |
| 1030 1031 1032 1033 | 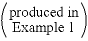 | | 100 mol % GaN 100 mol % GaN 100 mol % GaN 100 mol % GaN | Orientated polycrystal Single crystal Orientated polycryatal Orientated polycryatal | 9620 277 9590 9910 | 3.0 3.0 3.0 3.0 | 100 mol % AlN 100 mol % AlN 100 mol % GaN 100 mol % InN | 139 190 138 147 |
| 1034 | | | 100 mol % GaN | Orientated polycrystal | 9690 | 3.0 | 50 mol % GaN + | 141 |
| | | | | | | | 50 mol % InN | |
| 1035 | | | 100 mol % InN | Orientated polycrystal | 9610 | 3.0 | 100 mol % AlN | 139 |
| 1036 | | | 100 mol % InN | Single crystal | 283 | 3.0 | 100 mol % AlN | 188 |

TABLE 43

| | Characteristics | | Characteristics of the thin film which formed on the substrate which consists of various sintered compacts | | | | | |
|---|---|---|---|---|---|---|---|---|
| | of the sintered | | | | | | Thin film which formed furthermore | |
| | compact substrate | | Thin film which formed beforehand on the substrate | | | | on the thin film which formed | |
| | | Degree | | | | Half width | beforehand on the substrate | |
| | | of surface | | Formation | | of the (002) | | Half width of the |
| Exper- | | smooth- | Composition | method | | X ray diffrac- | Composition | (002) X ray |
| ment | Main | ness | of the | of the | | tion rocking | of the | diffraction rocking |
| No. | ingredient | Ra (nm) | thin film | thin film | Crystallized state | curve (second) | thin film | curve (second) |
| 1037 | Silicon | 6.8 | 100 mol % AlN | Sputter | Amorphous | — | 100 mol % AlN | 165 |
| 1038 | carbide | | 100 mol % AlN | Sputter | Orientated polycrystal | 9590 | 100 mol % AlN | 139 |
| 1039 1040 1041 1042 | 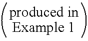 | 2.9 | 100 mol % AlN 100 mol % AlN 100 mol % AlN 100 mol % AlN | MOCVD Sputter Sputter Sputter | Orientated polycrystal Amorphous Polycrystal Orientated polycrystal | 7820 ——7710 | 100 mol % GaN 100 mol % AlN 100 mol % AlN 100 mol % AlN | 132 124 126 109 |
| 1043 | | | 100 mol % AlN | MOCVD | Single crystal | 207 | 100 mol % AlN | 127 |
| 1044 | | | 100 mol % AlN | MOCVD | Orientated polycrystal | 6620 | 100 mol % GaN | 107 |
| 1045 | | | 100 mol % GaN | MOCVD | Orientated polycrystal | 6880 | 100 mol % GaN | 116 |
| 1046 | | | 100 mol % InN | MOCVD | Orientated polycrystal | 6910 | 100 mol % GaN | 118 |
| 1047 | Silicon | 15 | 100 mol % AlN | Sputter | Amorphous | — | 100 mol % AlN | 189 |
| 1048 | nitride | | 100 mol % AlN | Sputter | Orientated polycrystal | 11910 | 100 mol % AlN | 169 |
| 1049 1050 1051 1052 | 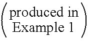 | 4.4 | 100 mol % AlN 100 mol % AlN 100 mol % AlN 100 mol % AlN | Sputter Sputter Sputter Sputter | Orientated polycrystal Amorphous Polycrystal Orientated polycrystal | 12030 ——7760 | 100 mol % GaN 100 mol % AlN 100 mol % AlN 100 mol % AlN | 173 125 128 110 |
| 1053 | | | 100 mol % AlN | MOCVD | Single crystal | 215 | 100 mol % AlN | 129 |
| 1054 | | | 100 mol % AlN | Sputter | Orientated polycrystal | 7680 | 100 mol % GaN | 109 |
| 1055 | | | 100 mol % GaN | MOCVD | Orientated polycrystal | 6780 | 100 mol % GaN | 113 |
| 1056 | Aluminum | 11 | 100 mol % AlN | Sputter | Amorphous | — | 100 mol % AlN | 177 |
| 1057 | oxide | | 100 mol % AlN | Sputter | Orientated polycrystal | 10630 | 100 mol % AlN | 159 |
| 1058 1059 1060 1061 | 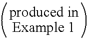 | 7.3 | 100 mol % AlN 100 mol % AlN 100 mol % AlN 100 mol % AlN | Sputter Sputter Sputter Sputter | Orientated polycrystal Amorphous Polycrystal Orientated polycrystal | 10570 ——9480 | 100 mol % GaN 100 mol % AlN 100 mol % AlN 100 mol % AlN | 154 157 162 136 |
| 1062 | | | 100 mol % AlN | MOCVD | Single crystal | 247 | 100 mol % AlN | 186 |
| 1063 | | | 100 mol % AlN | MOCVD | Orientated polycrystal | 7460 | 100 mol % GaN | 132 |
| 1064 | | | 100 mol % GaN | MOCVD | Orientated polycrystal | 7630 | 100 mol % GaN | 134 |
| 1065 | | 1.9 | 100 mol % AlN | Sputter | Amorphous | — | 100 mol % AlN | 123 |
| 1066 | | | 100 mol % AlN | Sputter | Polycrystal | — | 100 mol % AlN | 126 |
| 1067 | | | 100 mol % AlN | Sputter | Orientated polycrystal | 7580 | 100 mol % AlN | 106 |
| 1068 | | | 100 mol % AlN | MOCVD | Single crystal | 205 | 100 mol % AlN | 127 |
| 1069 | | | 100 mol % AlN | MOCVD | Orientated polycrystal | 6550 | 100 mol % GaN | 105 |
| 1070 | | | 100 mol % AlN | Sputter | Orientated polycrystal | 7710 | 50 mol % GaN + | 109 |
| | | | | | | | 50 mol % InN | |
| 1071 | | | 100 mol % GaN | MOCVD | Orientated polycrystal | 6760 | 100 mol % GaN | 111 |
| 1072 | | | 100 mol % InN | MOCVD | Orientated polycrystal | 6860 | 100 mol % GaN | 116 |
| 1073 | Zinc oxide | 8.8 | 100 mol % AlN | Sputter | Amorphous | — | 100 mol % AlN | 170 |
| 1074 1075 1076 1077 | 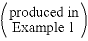 | 2.6 | 100 mol % AlN 100 mol % AlN 100 mol % AlN 100 mol % AlN | Sputter Sputter Sputter Sputter | Orientated polycrystal Orientated polycrystal Amorphous Polycrystal | 9560 9420 —— | 100 mol % AlN 100 mol % GaN 100 mol % AlN 100 mol % AlN | 137 135 121 124 |
| 1078 | | | 100 mol % AlN | Sputter | Orientated polycrystal | 7510 | 100 mol % AlN | 104 |
| 1079 | | | 100 mol % AlN | MOCVD | Single crystal | 211 | 100 mol % AlN | 127 |
| 1080 | | | 100 mol % AlN | MOCVD | Orientated polycrystal | 6480 | 100 mol % GaN | 103 |
| 1081 | | | 100 mol % AlN | Sputter | Orientated polycrystal | 7600 | 50 mol % AlN + | 107 |
| | | | | | | | 50 mol % GaN | |
| 1082 | | | 100 mol % GaN | MOCVD | Orientated polycrystal | 6730 | 100 mol % GaN | 110 |
| 1083 | | | 100 mol % InN | MOCVD | Orientated polycrystal | 6790 | 100 mol % GaN | 113 |
| 1084 | Beryllium | 9.4 | 100 mol % AlN | Sputter | Amorphous | — | 100 mol % AlN | 166 |
| 1085 | oxide | | 100 mol % AlN | Sputter | Orientated polycrystal | 9750 | 100 mol % AlN | 141 |
| 1086 1087 1088 1089 | 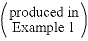 | 3.7 | 100 mol % AlN 100 mol % AlN 100 mol % AlN 100 mol % AlN | Sputter Sputter Sputter Sputter | Orientated polycrystal Amorphous Polycrystal Orientated polycrystal | 9570 ——7650 | 100 mol % GaN 100 mol % AlN 100 mol % AlN 100 mol % AlN | 138 124 127 111 |
| 1090 | | | 100 mol % AlN | MOCVD | Single crystal | 216 | 100 mol % AlN | 128 |
| 1091 | | | 100 mol % AlN | Sputter | Orientated polycrystal | 7690 | 100 mol % GaN | 109 |
| 1092 | | | 100 mol % GaN | MOCVD | Orientated polycrystal | 6320 | 100 mol % GaN | 114 |

TABLE 44

| | | | | Characteristics of the thin film formed on the substrate which consists of various sintered compacts | | | | | |
|---|---|---|---|---|---|---|---|---|---|
| | Characteristics of the sintered | | | Thin film which formed beforehand on the substrate | | | | Thin film which formed further- | |
| | compact substrate | | | | | | Halfwidth | more on the thin film which | |
| | | Degree | | | | | of the | formed beforehand on the substrate | |
| | | of | Processing | | | | (002) X ray | | Halfwidth of |
| Ex- | | surface | state | | Formation | | diffraction | | the (002) X |
| peri- | | smooth- | in the | Composition | method | Crystallized | rocking | Composition | ray diffraction |
| ment | Main | ness | surface of | of the | of the | state of | curve | of the | rocking curve |
| No. | ingredient | Ra (nm) | a substrate | thin film | thin film | thin film | (second) | thin film | (second) |
| 1093 | Aluminum | 160 | as-fired | 100 mol % AlN | Sputter | Amorphous | — | 100 mol % AlN | 94 |
| 1094 | nitride | | | 100 mol % AlN | Sputter | Orientated polycrystal | 7910 | 100 mol % AlN | 89 |
| 1095 1096 1097 1098 1099 1100 | 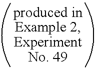 | 1160 2630 | Lap polish Blast polish | 100 mol % AlN 100 mol % AlN 100 mol % AlN 100 mol % AlN 100 mol % AlN 100 mol % AlN | Sputter Sputter Sputter MOCVD Sputter Sputter | Orientated | | | |
| # polycrystal Amorphous Orientated polycrystal Single crystal Amorphous Polycrystal | 8170 — 8850 720 —— | 100 mol % GaN 100 mol % AlN 100 mol % AlN 100 mol % GaN 100 mol % AlN 100 mol % AlN | 88 95 91 98 95 96 | | | | | | |
| 1101 | | | | 100 mol % AlN | Sputter | Orientated polycrystal | 9460 | 100 mol % AlN | 90 |
| 1102 | | | | 100 mol % AlN | MOCVD | Polycrystal | — | 100 mol % GaN | 97 |
| 1103 | | | | 100 mol % AlN | Sputter | Orientated polycrystal | 9630 | 100 mol % GaN | 91 |
| 1104 | | | | 100 mol % GaN | MOCVD | Orientated polycrystal | 4760 | 100 mol % GaN | 87 |
| 1105 | Silicon | 1460 | as-fired | 100 mol % AlN | Sputter | Amorphous | — | 100 mol % AlN | 184 |
| 1106 | carbide | | | 100 mol % AlN | Sputter | Orientated polycrystal | 15200 | 100 mol % AlN | 146 |
| 1107 1108 1109 1110 | 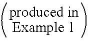 | 820 | Lap polish | 100 mol % AlN 100 mol % AlN 100 mol % AlN 100 mol % AlN | MOCVD Sputter Sputter MOCVD | Polycrystal Amorphous Orientated polycrystal Single crystal | ——13900 2310 | 100 mol % GaN 100 mol % AlN 100 mol % AlN 100 mol % GaN | 181 176 139 192 |
| 1111 | | 1550 | Blast | 100 mol % AlN | Sputter | Amorphous | — | 100 mol % AlN | 184 |
| 1112 | | | polish | 100 mol % AlN | Sputter | Orientated polycrystal | 16900 | 100 mol % AlN | 141 |
| 1113 | | | | 100 mol % AlN | MOCVD | Polycrystal | — | 100 mol % GaN | 179 |
| 1114 | Silicon | 760 | as-fired | 100 mol % AlN | Sputter | Amorphous | — | 100 mol % AlN | 185 |
| 1115 | nitride | | | 100 mol % AlN | Sputter | Orientated polycrystal | 15100 | 100 mol % AlN | 146 |
| 1116 1117 1118 1119 | 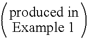 | 140 | Lap polish | 100 mol % AlN 100 mol % AlN 100 mol % AlN 100 mol % AlN | MOCVD Sputter Sputter Sputter | Single crystal Amorphous Orientated polycrystal Orientated polycrystal | 2060 —13700 14300 | 100 mol % GaN 100 mol % AlN 100 mol % AlN 100 mol % GaN | 188 169 137 143 |
| 1120 | | 1270 | Blast | 100 mol % AlN | Sputter | Amorphous | — | 100 mol % AlN | 172 |
| 1121 | | | polish | 100 mol % AlN | Sputter | Orientated polycrystal | 16200 | 100 mol % AlN | 145 |
| 1122 | | | | 100 mol % AlN | MOCVD | Polycrystal | — | 100 mol % GaN | 183 |
| 1123 | Aluminum | 920 | as-fired | 100 mol % AlN | Sputter | Amorphous | — | 100 mol % AlN | 146 |
| 1124 | oxide | | | 100 mol % AlN | Sputter | Orientated polycrystal | 13800 | 100 mol % AlN | 127 |
| 1125 1126 1127 1128 | 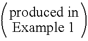 | 610 | Lap polish | 100 mol % AlN 100 mol % AlN 100 mol % AlN 100 mol % AlN | MOCVD Sputter Sputter Sputter | Single crystal Amorphous Orientated polycrystal Orientated polycrystal | 1930 —13300 12800 | 100 mol % GaN 100 mol % AlN 100 mol % AlN 100 mol % GaN | 176 153 132 129 |
| 1129 | | 1230 | Blast | 100 mol % AlN | Sputter | Amorphous | — | 100 mol % AlN | 158 |
| 1130 | | | polish | 100 mol % AlN | Sputter | Orientated polycrystal | 15400 | 100 mol % AlN | 134 |
| 1131 | | | | 100 mol % AlN | MOCVD | Polycrystal | — | 100 mol % GaN | 170 |
| 1132 | Zinc oxide | 740 | as-fire | 100 mol % AlN | Sputter | Amorphous | — | 100 mol % AlN | 143 |
| 1133 1134 1135 1136 | 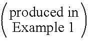 | 630 | Lap polish | 100 mol % AlN 100 mol % | | | | | |
| # AlN 100 mol % AlN 100 mol % AlN | Sputter MOCVD Sputter Sputter | Orientated polycrystal Single crystal Amorphous Orientated polycrystal | 13700 1840 —14700 | 100 mol % AlN 100 mol % GaN 100 mol % AlN 100 mol % AlN | 124 173 140 125 | | | | |
| 1137 | | | | 100 mol % AlN | Sputter | Orientated polycrystal | 15100 | 100 mol % GaN | 122 |
| 1138 | | 2130 | Blast | 100 mol % AlN | Sputter | Amorphous | — | 100 mol % AlN | 156 |
| 1139 | | | polish | 100 mol % AlN | Sputter | Orientated polycrystal | 16100 | 100 mol % AlN | 138 |
| 1140 | | | | 100 mol % AlN | MOCVD | Polycrystal | — | 100 mol % GaN | 171 |
| 1141 | Beryllium | 340 | as-fired | 100 mol % AlN | Sputter | Amorphous | — | 100 mol % AlN | 149 |
| 1142 | oxide | | | 100 mol % AlN | Sputter | Orientated polycrystal | 13600 | 100 mol % AlN | 129 |
| 1143 1144 1145 1146 | 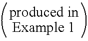 | 1410 | Lap polish | 100 mol % AlN 100 mol % AlN 100 mol % AlN 100 mol % AlN | Sputter Sputter Sputter MOCVD | Orientated polycrystal Amorphous Orientated polycrystal Polycrystal | 13600 —16600 — | 100 mol % GaN 100 mol % AlN 100 mol % AlN 100 mol % GaN | 127 157 139 173 |
| 1147 | | 950 | Blast | 100 mol % AlN | Sputter | Amorphous | — | 100 mol % AlN | 151 |
| 1148 | | | polish | 100 mol % AlN | Sputter | Orientated polycrystal | 15200 | 100 mol % AlN | 134 |
| 1149 | | | | 100 mol % AlN | MOCVD | Single crystal | 2310 | 100 mol % GaN | 170 |

TABLE 45

| | Characteristics of the | | | Characteristics of the thin film which formed on the substrate which consists of a sintered | | | | |
|---|---|---|---|---|---|---|---|---|
| | substrate which consists | | | compact which comprises a zinc oxide as the main ingredients | | | | |
| | of a sintered compact which comprises | | | This film which formed beforehand on the substrate | | | Thin film which formed | |
| | a zinc oxide as the main ingredients | | | which consists of a sintered compact which comprises | | | furthermore on the thin film which | |
| | Composition | Electric | | a zinc oxide as the main ingredients | | | formed beforehand on the substrate | |
| Experi- | 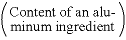 | resistivity (Ω · cm) (room | Optical transmis- | Composition | Crystallized state | Half width of the (002) X ray diffraction | Composition | Half width of the (002) X ray diffraction |
| ment | (mol %: | temp- | sivity | of the | of the | rocking curve | of the | rocking curve |
| No. | Al₂O₃ conversion) | erature) | (%) | thin film | thin film | (second) | thin film | (second) |
| 1150 | 0.000 | >1 × | 16 | (not formed) | — | — | 100 mol % AlN | 255 |
| 1151 | | 10⁸ | | 100 mol % AlN | Orienteted polycrystal | 9430 | 100 mol % AlN | 136 |
| 1152 | 0.002 | 6.8 × | 22 | (not formed) | — | — | 100 mol % AlN | 187 |
| 1153 | | 10¹ | | 100 mol % AlN | Amorphous | — | 100 mol % AlN | 126 |
| 1154 | | | | 100 mol % AlN | Orientated polycrystal | 8190 | 100 mol % AlN | 107 |
| 1155 | 0.008 | 7.9 × | 24 | (not formed) | — | — | 100 mol % AlN | 159 |
| 1156 | | 10⁰ | | 100 mol % AlN | Orientated polycrystal | 7620 | 100 mol % AlN | 97 |
| 1157 | 0.03 | 7.4 × | 27 | (not formed) | — | — | 100 mol % GaN | 138 |
| 1158 | | 10⁻¹ | | 100 mol % AlN | Orientated polycrystal | 7690 | 100 mol % GaN | 95 |
| 1159 | 0.10 | 8.4 × | 36 | (not formed) | — | — | 100 mol % AlN | 126 |
| 1160 | | × 10⁻² | | 100 mol % AlN | Orientated polycrystal | 7490 | 100 mol % AlN | 94 |
| 1161 | | | | 100 mol % AlN | Orientated polycrystal | 7650 | 100 mol % GaN | 93 |
| 1162 | 0.30 | 7.7 × | 44 | (not formed) | — | — | 100 mol % AlN | 125 |
| 1163 | | 10⁻³ | | 100 mol % AlN | Orientated polycrystal | 7540 | 100 mol % AlN | 93 |
| 1164 | 1.0 | 2.9 × | 53 | (not formed) | — | — | 100 mol % AlN | 121 |
| 1165 | | 10⁻³ | 53 | 100 mol % AlN | Amorphous | — | 100 mol % AlN | 96 |
| 1166 | | | | 100 mol % AlN | Orientated polycrystal | 7470 | 100 mol % AlN | 89 |
| 1167 | 3.0 | 1.6 × | 56 | (not formed) | — | — | 100 mol % AlN | 112 |
| 1168 | | 10⁻³ | | (not formed) | — | — | 100 mol % GaN | 118 |
| 1169 | | | | (not formed) | — | — | 100 mol % InN | 119 |
| 1170 | | | | 100 mol % AlN | Amorphous | — | 100 mol % AlN | 94 |
| 1171 | | | | 100 mol % AlN | Polycrystal | — | 100 mol % AlN | 96 |
| 1172 | | | | 100 mol % AlN | Orientated polycrystal | 7350 | 100 mol % AlN | 86 |
| 1173 | | | | 100 mol % AlN | Orientated polycrystal | 7320 | 100 mol % GaN | 88 |
| 1174 | | | | 100 mol % AlN | Orientated polycrystal | 7460 | 100 mol % InN | 89 |
| 1175 | | | | 100 mol % AlN | Orientated polycrystal | 7390 | 50 mol % AlN + | 87 |
| | | | | | | | 50 mol % GaN | |
| 1176 | | | | 100 mol % AlN | Single crystal | 115 | 100 mol % AlN | 96 |
| 1177 | | | | 100 mol % GaN | Amorphous | — | 100 mol % AlN | 93 |
| 1178 | | | | 100 mol % GaN | Orientated polycrystal | 7180 | 100 mol % AlN | 88 |
| 1179 | | | | 100 mol % InN | Orientated polycrystal | 7240 | 100 mol % AlN | 90 |
| 1180 | 10.0 | 6.3 × | 52 | (not formed) | — | — | 100 mol % AlN | 118 |
| 1181 | | 10⁻³ | | 100 mol % AlN | Orientated polycrystal | 7410 | 100 mol % AlN | 88 |
| 1182 | | | | 100 mol % AlN | Orientated polycrystal | 7390 | 100 mol % GaN | 91 |
| 1183 | | | | 100 mol % AlN | Orientated polycryatal | 7440 | 50 mol % GaN + | 89 |
| | | | | | | | 50 mol % InN | |
| 1184 | 20.0 | 8.9 × | 42 | (not formed) | — | — | 100 mol % InN | 119 |
| 1185 | | 10⁻³ | | 100 mol % AlN | Orientated polycrystal | 7510 | 100 mol % InN | 92 |
| 1186 | 30.0 | 8.2 × | 33 | (not formed) | — | — | 100 mol % GaN | 127 |
| 1187 | | 10⁻² | | 100 mol % AlN | Amorphous | — | 100 mol % GaN | 96 |
| 1188 | | | | 100 mol % AlN | Orientated polycrystal | 7500 | 100 mol % GaN | 91 |
| 1189 | 40.0 | 7.8 × | 31 | (not formed) | — | — | 100 mol % AlN | 136 |
| 1190 | | 10⁻¹ | | 100 mol % AlN | Orientated polycrystal | 7570 | 100 mol % AlN | 94 |
| 1191 | | | | 100 mol % AlN | Orientated polycrystal | 7530 | 100 mol % InN | 97 |
| 1192 | 50.0 | >1 × | 17 | (not formed) | — | — | 100 mol % AlN | 229 |
| 1193 | | 10⁸ | | 100 mol % AlN | Orientated polycrystal | 9260 | 100 mol % AlN | 134 |
| 1194 | 1.0 | 8.7 × | 6.9 | (not formed) | — | — | 100 mol % AlN | 227 |
| 1195 | (Fe₂O₃) | 10⁻¹ | | 100 mol % AlN | Orientated polycrystal | 8710 | 100 mol % AlN | 124 |
| 1196 | 1.0 | 3.4 | 9.2 | (not formed) | — | — | 100 mol % GaN | 220 |
| 1197 | (Cr₂O₃) | 10⁻¹ | | 100 mol % AlN | Orientated polycrystal | 8890 | 100 mol % GaN | 119 |
| 1198 | 0.04 | >1 × | 57 | (not formed) | — | — | 100 mol % AlN | 192 |
| 1199 | (Y₂O₃) | 10⁸ | | 100 mol % AlN | Orientated polycrystal | 7770 | 100 mol % AlN | 104 |
| 1200 | 0.04 | >1 × | 53 | (not formed) | — | — | 100 mol % GaN | 206 |
| 1201 | (Er₂O₃) | 10⁸ | | 100 mol % AlN | Orientated polycrystal | 7940 | 100 mol % GaN | 107 |
| 1202 | 0.04 | >1 × | 54 | (not formed) | — | — | 100 mol % AlN | 203 |
| 1203 | (Yb₂O₃) | 10⁶ | | 100 mol % AlN | Orientated polycrystal | 7860 | 100 mol % AlN | 109 |

TABLE 46

| | Characteristics of the substrate | | | | Characteristics of the thin film which formed on the substrate which consists of | | | |
|---|---|---|---|---|---|---|---|---|
| | which consists of a sintered compact which | | | | a sintered compact which comprises a zinc oxide as the main ingredients | | | |
| | comprises a zinc oxide as the main ingredients | | | | | | Thin film which formed | |
| | Composition of | | | | | | furthermore on the thin film which | |
| | the sintered compact | | | | Crystallinity of the AlN thin film which | | formed beforehand on the substrate | |
| | [Ingredient content] | | Electric | Optical | formed beforehand on the substrate | | | Half width of |
| | (mol %: oxide conversion) | | resistivity | transmis- | | Half width of | | the (002) X ray |
| | Component | | (Ω · cm) | sivity | | the (002) X ray | Composition | diffraction |
| Experiment | | Except | (room | (%) | | diffraction rocking | of | rocking |
| No. | Aluminum | aluminum | temperature) | [605 nm] | Crystallized state | curve (second) | the thin film | curve (second) |
| 1204 | 3.0 | 0.2 | 2.3 × 10⁻³ | 53 | (not formed) | — | 100 mol % AlN | 116 |
| 1205 | | (Fe₂O₃) | | | Orientated polycrystal | 7510 | 100 mol % AlN | 89 |
| 1206 | 3.0 | 0.2 | 1.9 × 10⁻³ | 55 | (not formed) | — | 100 mol % AlN | 114 |
| 1207 | | (Cr₂O₃) | | | Orientated polycrystal | 7430 | 100 mol % AlN | 88 |
| 1208 | 0.03 | 0.0001 | 7.3 × 10⁻¹ | 28 | (not formed) | — | 100 mol % AlN | 138 |
| 1209 | | (Y₃O₃) | | | Orientated polycrystal | 7670 | 100 mol % AlN | 96 |
| 1210 | 0.03 | 0.0004 | 7.4 × 10⁻¹ | 37 | (not formed) | — | 100 mol % GaN | 140 |
| 1211 | | (Y₂O₃) | | | Orientated polycrystal | 7590 | 100 mol % GaN | 95 |
| 1212 | 0.03 | 0.0008 | 7.4 × 10⁻¹ | 45 | (not formed) | — | 100 mol % AlN | 139 |
| 1213 | | (Y₂O₃) | | | Orientated polycrystal | 7610 | 100 mol % AlN | 96 |
| 1214 | 0.03 | 0.0015 | 7.6 × 10⁻¹ | 56 | (not formed) | — | 100 mol % AlN | 136 |
| 1215 | | (Y₂O₃) | | | Orientated polycrystal | 7540 | 100 mol % AlN | 95 |
| 1216 | 0.03 | 0.005 | 7.5 × 10⁻¹ | 64 | (not formed) | — | 100 mol % AlN | 134 |
| 1217 | | (Y₂O₃) | | | Orientated polycrystal | 7560 | 100 mol % AlN | 95 |
| 1218 | 0.03 | 0.04 | 7.8 × 10⁻¹ | 68 | (not formed) | — | 100 mol % AlN | 142 |
| 1219 | | (Y₂O₃) | | | Orientated polycrystal | 7520 | 100 mol % AlN | 93 |
| 1220 | 0.03 | 0.2 | 7.7 × 10⁻¹ | 65 | (not formed) | — | 100 mol % AlN | 140 |
| 1221 | | (Y₂O₃) | | | Orientated polycrystal | 7630 | 100 mol % AlN | 95 |
| 1222 | 0.03 | 1.0 | 7.9 × 10⁻¹ | 62 | (not formed) | — | 100 mol % AlN | 138 |
| 1223 | | (Y₂O₃) | | | Orientated polycrystal | 7580 | 100 mol % AlN | 94 |
| 1224 | 0.03 | 5.0 | 8.2 × 10⁻¹ | 54 | (not formed) | — | 100 mol % AlN | 143 |
| 1225 | | (Y₂O₃) | | | Orientated polycrystal | 7490 | 100 mol % AlN | 93 |
| 1226 | 0.03 | 8.0 | 8.7 × 10⁻¹ | 37 | (not formed) | — | 100 mol % AlN | 141 |
| 1227 | | (Y₂O₃) | | | Orientated polycrystal | 7530 | 100 mol % AlN | 96 |
| 1228 | 0.03 | 12.0 | 9.2 × 10⁻¹ | 24 | (not formed) | — | 100 mol % AlN | 145 |
| 1229 | | (Y₂O₃) | | | Orientated polycrystal | 7720 | 100 mol % AlN | 97 |
| 1230 | 0.002 | 0.04 | 7.4 × 10¹ | 62 | (not formed) | — | 100 mol % AlN | 175 |
| 1231 | | (Y₂O₃) | | | Orientated polycrystal | 7920 | 100 mol % AlN | 107 |
| 1232 | 0.008 | 0.04 | 8.2 × 10⁰ | 66 | (not formed) | — | 100 mol % AlN | 157 |
| 1233 | | (Y₂O₃) | | | Orientated polycrystal | 7630 | 100 mol % AlN | 96 |
| 1234 | 0.10 | 0.04 | 8.8 × 10⁻² | 71 | (not formed) | — | 100 mol % AlN | 125 |
| 1235 | | (Y₂O₃) | | | Orientated polycrystal | 7590 | 100 mol % AlN | 94 |
| 1236 | 0.30 | 0.04 | 8.2 × 10⁻³ | 75 | (not formed) | — | 100 mol % AlN | 122 |
| 1237 | | (Y₂O₃) | | | Orientated polycrystal | 7510 | 100 mol % AlN | 92 |
| 1238 | 1.0 | 0.04 | 3.3 × 10⁻³ | 84 | (not formed) | — | 100 mol % GaN | 119 |
| 1239 | | (Y₂O₃) | | | Orientated polycrystal | 7530 | 100 mol % GaN | 89 |
| 1240 | 3.0 | 0.04 | 1.7 × 10⁻³ | 84 | (not formed) | — | 100 mol % AlN | 111 |
| 1241 | | (Y₂O₃) | | | Orientated polycrystal | 7470 | 100 mol % AlN | 87 |
| 1242 | 10.0 | 0.04 | 6.9 × 10⁻³ | 74 | (not formed) | — | 100 mol % AlN | 117 |
| 1243 | | (Y₂O₃) | | | Orientated polycrystal | 7420 | 100 mol % AlN | 88 |
| 1244 | 30.0 | 0.04 | 9.5 × 10⁻² | 66 | (not formed) | — | 100 mol % AlN | 126 |
| 1245 | | (Y₂O₃) | | | Orientated polycrystal | 7530 | 100 mol % AlN | 90 |
| 1246 | 50.0 | 0.04 | | 27 | (not formed) | — | 100 mol % AlN | 225 |
| 1247 | | (Y₂O₃) | >1 × 10⁸ | | Orientated polycrystal | 9380 | 100 mol % AlN | 136 |
| 1248 | 0.10 | 0.04 | 8.9 × 10⁻² | 68 | (not formed) | — | 100 mol % AlN | 124 |
| 1249 | | (Er₂O₃) | | | Orientated polycrystal | 7520 | 100 mol % AlN | 94 |
| 1250 | 3.0 | 0.04 | 2.2 × 10⁻³ | 77 | (not formed) | — | 100 mol % GaN | 116 |
| 1251 | | (Dy₂O₃) | | | Orientated polycrystal | 7380 | 100 mol % GaN | 87 |
| 1252 | 3.0 | 0.04 | 1.8 × 10⁻³ | 80 | (not formed) | — | 100 mol % AlN | 117 |
| 1253 | | (Ho₂O₃) | | | Orientated polycrystal | 7490 | 100 mol % AlN | 87 |
| 1254 | 3.0 | 0.04 | 1.9 × 10⁻³ | 78 | (not formed) | — | 100 mol % AlN | 116 |
| 1255 | | (Er₂O₃) | | | Orientated polycrystal | 7420 | 100 mol % AlN | 87 |
| 1256 | 3.0 | 0.04 | 2.0 × 10⁻³ | 81 | (not formed) | — | 100 mol % GaN | 113 |
| 1257 | | (Yb₂O₃) | | | Orientated polycrystal | 7440 | 100 mol % GaN | 88 |
| 1258 | 3.0 | 0.04 | 3.5 × 10⁻³ | 83 | (not formed) | — | 100 mol % GaN | 116 |
| 1259 | | (Y₂O₂) + 0.04 | | | Amorphous | — | 100 mol % AlN | 93 |
| 1260 | | (Er₂O₃) | | | Polycrystal | — | 100 mol % AlN | 96 |
| 1261 | | | | | Orientated polycrystal | 7550 | 100 mol % GaN | 87 |

TABLE 47

| | Characteristics of the substrate which | | | | | | | |
|---|---|---|---|---|---|---|---|---|
| | consists of a sintered compact which comprises | | | | | | | |
| | a beryllium oxide as the main ingredients | | | | | Characteristics of the thin film which formed on the substrate | | |
| | Composition of the sintered compact | | | | | | Thin film which formed furthermore on | |
| | [Ingredient content] | | | | | Half width of the rocking | the thin film which formed | |
| | (mol %; oxide conversion) | | | | Optical | curve of the AlN orientated | beforehand on the substrate | |
| | Component | | | | transmissivity | polycrystal thin film which | Composition | Half width of the (002) |
| Experiment | | | | Other | (%) | formed beforehand on the | of | X ray diffraction |
| No. | Magnesium | Calcium | Silicon | ingredients | [605 nm] | substrate (second) | the thin film | rocking curve (second) |
| 1262 | 0.0000 | 0.0000 | 0.0000 | 0.0000 | 14 | — (not formed) | 100 mol % AlN | 270 |
| 1263 | | | | (not added) | | 9670 | 100 mol % AlN | 139 |
| 1264 | 0.0001 | 0.0000 | 0.0000 | 0.0000 | 19 | — (not formed) | 100 mol % AlN | 221 |
| 1265 | | | | (not added) | | 9120 | 100 mol % AlN | 132 |
| 1266 | 0.0000 | 0.0004 | 0.0000 | 0.0000 | 26 | — (not formed) | 100 mol % AlN | 191 |
| 1267 | | | | (not added) | | 8540 | 100 mol % AlN | 124 |
| 1268 | 0.0000 | 0.0000 | 0.0020 | 0.0000 | 25 | — (not formed) | 100 mol % GaN | 168 |
| 1269 | | | | (not added) | | 7710 | 100 mol % GaN | 96 |
| 1270 | 0.0080 | 0.0000 | 0.0000 | 0.0000 | 31 | — (not formed) | 100 mol % AlN | 142 |
| 1271 | | | | (not added) | | 7740 | 100 mol % AlN | 95 |
| 1272 | 0.000 | 0.020 | 0.000 | 0.000 | 37 | — (not formed) | 100 mol % AlN | 122 |
| 1273 | | | | (not added) | | 7560 | 100 mol % AlN | 95 |
| 1274 | 0.00 | 0.00 | 0.40 | 0.00 | 36 | — (not formed) | 100 mol % AlN | 127 |
| 1275 | | | | (not added) | | 7730 | 100 mol % AlN | 97 |
| 1276 | 0.00 | 0.45 | 0.00 | 0.00 | 57 | — (not formed) | 100 mol % AlN | 109 |
| 1277 | | | | (not added) | | 7340 | 100 mol % AlN | 89 |
| 1278 | 0.60 | 0.00 | 0.00 | 0.00 | 45 | — (not formed) | 100 mol % AlN | 124 |
| 1279 | | | | (not added) | | 7540 | 100 mol % AlN | 95 |
| 1280 | 0.00 | 0.45 | 0.20 | 0.00 | 54 | — (not formed) | 100 mol % AlN | 108 |
| 1281 | | | | (not added) | | 7190 | 100 mol % AlN | 89 |
| 1282 | 0.60 | 0.00 | 0.20 | 0.00 | 47 | — (not formed) | 100 mol % AlN | 125 |
| 1283 | | | | (not added) | | 7650 | 100 mol % AlN | 96 |
| 1284 | 0.60 | 0.45 | 0.00 | 0.00 | 55 | — (not formed) | 100 mol % AlN | 114 |
| 1285 | | | | (not added) | | 7340 | 100 mol % AlN | 90 |
| 1286 | 0.60 | 0.45 | 0.20 | 0.00 | 52 | — (not formed) | 100 mol % AlN | 112 |
| 1287 | | | | (not added) | | 7290 | 100 mol % AlN | 92 |
| 1288 | 0.00 | 3.00 | 0.00 | 0.00 | 50 | — (not formed) | 100 mol % AlN | 111 |
| 1289 | | | | (not added) | | 7370 | 100 mol % AlN | 91 |
| 1290 | 0.00 | 10.00 | 0.00 | 0.00 | 53 | — (not formed) | 100 mol % AlN | 117 |
| 1291 | | | | (not added) | | 7410 | 100 mol % AlN | 93 |
| 1292 | 00.00 | 20.00 | 0.00 | 0.00 | 42 | — (not formed) | 100 mol % AlN | 119 |
| 1293 | | | | (not added) | | 7590 | 100 mol % AlN | 95 |
| 1294 | 30.00 | 0.00 | 0.00 | 0.00 | 24 | — (not formed) | 100 mol % AlN | 132 |
| 1295 | | | | (not added) | | 7650 | 100 mol % AlN | 96 |
| 1296 | 40.00 | 0.00 | 0.00 | 0.00 | 7.6 | — (not formed) | 100 mol % AlN | 217 |
| 1297 | | | | (not added) | | 9480 | 100 mol % AlN | 142 |
| 1298 | 0.0000 | 0.0004 | 0.0000 | 0.0002 | 35 | — (not formed) | 100 mol % AlN | 182 |
| 1299 | | | | (Y₂O₃) | | 7960 | 100 mol % AlN | 119 |
| 1300 | 0.000 | 0.020 | 0.000 | 0.0010 | 47 | — (not formed) | 100 mol % AlN | 121 |
| 1301 | | | | (Y₂O₃) | | 7490 | 100 mol % AlN | 93 |
| 1302 | 0.000 | 0.020 | 0.000 | 0.0040 | 54 | — (not formed) | 100 mol % AlN | 120 |
| 1303 | | | | (Y₂O₃) | | 7420 | 100 mol % AlN | 94 |
| 1304 | 0.000 | 0.020 | 0.000 | 0.010 | 67 | — (not formed) | 100 mol % GaN | 118 |
| 1305 | | | | (Y₂O₃) | | 7340 | 100 mol % GaN | 92 |
| 1306 | 0.00 | 0.45 | 0.00 | 0.040 | 81 | — (not formed) | 100 mol % AlN | 104 |
| 1307 | | | | (Y₂O₃) | | 7240 | 100 mol % AlN | 88 |
| 1308 | 0.0000 | 0.0004 | 0.0000 | 4.0 | 37 | — (not formed) | 100 mol % GaN | 176 |
| 1309 | | | | (Y₂O₃) | | 7890 | 100 mol % GaN | 121 |
| 1310 | 0.0000 | 0.0004 | 0.0000 | 6.0 | 28 | — (not formed) | 100 mol % AlN | 189 |
| 1311 | | | | (Y₂O₃) | | 7930 | 100 mol % AlN | 126 |
| 1312 | 0.00 | 0.45 | 0.00 | 0.040 | 76 | — (not formed) | 100 mol % GaN | 110 |
| 1313 | | | | (DY₂O₃) | | 7310 | 100 mol % GaN | 91 |
| 1314 | 0.00 | 0.45 | 0.00 | 0.040 | 75 | — (not formed) | 100 mol % AlN | 107 |
| 1315 | | | | (Ho₂O₃) | | 7360 | 100 mol % AlN | 90 |
| 1316 | 0.00 | 0.45 | 0.00 | 0.040 | 80 | — (not formed) | 100 mol % AlN | 108 |
| 1317 | | | | (Er₂O₃) | | 7280 | 100 mol % AlN | 89 |
| 1318 | 0.00 | 0.45 | 0.00 | 0.040 | 78 | — (not formed) | 100 mol % GaN | 106 |
| 1319 | | | | (Yb₂O₃) | | 7330 | 100 mol % GaN | 90 |
| 1320 | 0.00 | 0.45 | 0.20 | 0.040 | 80 | — (not formed) | 100 mol % GaN | 109 |
| 1321 | | | | (Y₂O₃) | | 7220 | 100 mol % GaN | 89 |

TABLE 47

| | Characteristics of the substrate which | | | | | | | |
|---|---|---|---|---|---|---|---|---|
| | consists of a sintered compact which comprises | | | | | | | |
| | an aluminum oxide as the main ingredients | | | | | Characteristics of the thin film which formed on the substrate | | |
| | Composition of the sintered compact | | | | | | Thin film which formed | |
| | [Ingredient content] | | | | | Half width of the rocking | furthermore on the thin film which formed | |
| | (mol %; oxide conversion) | | | | Optical | curve of the AlN orientated | beforehand on the substrate | |
| | Component | | | | transmissivity | polycrystal thin film which | Composition | Half width of the (002) |
| Experiment | | | | Other | (%) | formed beforehand on the | of | X ray diffraction |
| No. | Magnesium | Calcium | Silicon | ingredients | [605 nm] | substrate (second) | the thin film | rocking curve (second) |
| 1322 | 0.0000 | 0.0000 | 0.0000 | 0.0000 | 18 | — (not formed) | 100 mol % AlN | 274 |
| 1323 | | | | (not added) | | 9720 | 100 mol % AlN | 142 |
| 1324 | 0.0000 | 0.0005 | 0.0000 | 0.0000 | 17 | — (not formed) | 100 mol % AlN | 215 |
| 1325 | | | | (not added) | | 9240 | 100 mol % AlN | 133 |
| 1326 | 0.0000 | 0.0000 | 0.0020 | 0.0000 | 24 | — (not formed) | 100 mol % AlN | 187 |
| 1327 | | | | (not added) | | 8660 | 100 mol % AlN | 122 |
| 1328 | 0.010 | 0.000 | 0.000 | 0.000 | 43 | — (not formed) | 100 mol % AlN | 156 |
| 1329 | | | | (not added) | | 7810 | 100 mol % AlN | 96 |
| 1330 | 0.000 | 0.050 | 0.000 | 0.000 | 36 | — (not formed) | 100 mol % AlN | 140 |
| 1331 | | | | (not added) | | 7830 | 100 mol % AlN | 97 |
| 1332 | 0.12 | 0.00 | 0.00 | 0.00 | 51 | — (not formed) | 100 mol % GaN | 119 |
| 1333 | | | | (not added) | | 7350 | 100 mol % GaN | 92 |
| 1334 | 0.60 | 0.00 | 0.20 | 0.00 | 47 | — (not formed) | 100 mol % AlN | 116 |
| 1335 | | | | (not added) | | 7310 | 100 mol % AlN | 93 |
| 1336 | 1.20 | 0.00 | 0.00 | 0.00 | 57 | — (not formed) | 100 mol % GaN | 114 |
| 1337 | | | | (not added) | | 7260 | 100 mol % GaN | 90 |
| 1338 | 1.00 | 0.20 | 0.00 | 0.00 | 55 | — (not formed) | 100 mol % AlN | 113 |
| 1339 | | | | (not added) | | 7240 | 100 mol % AlN | 91 |
| 1340 | 0.00 | 1.00 | 1.00 | 0.00 | 27 | — (not formed) | 100 mol % AlN | 124 |
| 1341 | | | | (not added) | | 7690 | 100 mol % AlN | 96 |
| 1342 | 0.60 | 0.80 | 0.80 | 0.00 | 46 | — (not formed) | 100 mol % GaN | 120 |
| 1343 | | | | (not added) | | 7740 | 100 mol % GaN | 94 |
| 1344 | 3.00 | 0.00 | 0.00 | 0.00 | 52 | — (not formed) | 100 mol % AlN | 117 |
| 1345 | | | | (not added) | | 7270 | 100 mol % AlN | 92 |
| 1346 | 2.00 | 2.00 | 4.00 | 0.00 | 50 | — (not formed) | 100 mol % AlN | 119 |
| 1347 | | | | (not added) | | 7480 | 100 mol % AlN | 93 |
| 1348 | 10.00 | 0.00 | 0.00 | 0.00 | 47 | — (not formed) | 100 mol % AlN | 124 |
| 1349 | | | | (not added) | | 7520 | 100 mol % AlN | 96 |
| 1350 | 6.00 | 2.00 | 8.00 | 0.00 | 41 | — (not formed) | 100 mol % GaN | 125 |
| 1351 | | | | (not added) | | 7450 | 100 mol % GaN | 92 |
| 1352 | 2.00 | 2.00 | 26.00 | 0.00 | 44 | — (not formed) | 100 mol % AlN | 126 |
| 1353 | | | | (not added) | | 7670 | 100 mol % AlN | 96 |
| 1354 | 0.00 | 20.00 | 20.00 | 0.00 | 22 | — (not formed) | 100 mol % AlN | 141 |
| 1355 | | | | (not added) | | 7830 | 100 mol % AlN | 97 |
| 1356 | 20.00 | 0.00 | 30.00 | 0.00 | 6.4 | — (not formed) | 100 mol % AlN | 226 |
| 1357 | | | | (not added) | | 9370 | 100 mol % AlN | 147 |
| 1358 | 0.000 | 0.050 | 0.000 | 0.040 | 37 | — (not formed) | 100 mol % AlN | 137 |
| 1359 | | | | (Y₂O₃) | | 7760 | 100 mol % AlN | 95 |
| 1360 | 1.20 | 0.00 | 0.00 | 0.040 | 59 | — (not formed) | 100 mol % GaN | 112 |
| 1361 | | | | (Y₂O₃) | | 7250 | 100 mol % GaN | 89 |
| 1362 | 1.20 | 0.00 | 0.00 | 0.040 | 56 | — (not formed) | 100 mol % AlN | 115 |
| 1363 | | | | (Ho₂O₃) | | 7310 | 100 mol % AlN | 91 |
| 1364 | 1.20 | 0.00 | 0.00 | 0.040 | 58 | — (not formed) | 100 mol % GaN | 115 |
| 1365 | | | | (Yb₂O₃) | | 7290 | 100 mol % GaN | 90 |
| 1366 | 0.000 | 1.00 | 1.00 | 0.0005 | 33 | — (not formed) | 100 mol % AlN | 118 |
| 1367 | | | | (Y₂O₃) | | 7600 | 100 mol % AlN | 94 |
| 1368 | 0.60 | 0.80 | 0.80 | 0.0080 | 57 | — (not formed) | 100 mol % AlN | 111 |
| 1369 | | | | (Y₂O₃) | | 7390 | 100 mol % AlN | 92 |
| 1370 | 0.60 | 0.00 | 0.20 | 0.040 | 69 | — (not formed) | 100 mol % AlN | 112 |
| 1371 | | | | (Y₂O₃) | | 7480 | 100 mol % AlN | 91 |
| 1372 | 0.000 | 1.00 | 1.00 | 8.0 | 36 | — (not formed) | 100 mol % GaN | 121 |
| 1373 | | | | (Y₂O₃) | | 7680 | 100 mol % GaN | 94 |
| 1374 | 0.000 | 1.00 | 1.00 | 12.0 | 27 | — (not formed) | 100 mol % AlN | 124 |
| 1375 | | | | (Y₂O₃) | | 7830 | 100 mol % AlN | 97 |
| 1376 | 1.00 | 0.20 | 0.00 | 0.040 | 82 | — (not formed) | 100 mol % AlN | 107 |
| 1377 | | | | (Y₂O₃) | | 7070 | 100 mol % AlN | 88 |
| 1378 | 1.00 | 0.20 | 0.00 | 0.040 | 78 | — (not formed) | 100 mol % AlN | 113 |
| 1379 | | | | (Dy₂O₃) | | 7240 | 100 mol % AlN | 90 |
| 1380 | 1.00 | 0.20 | 0.00 | 0.040 | 81 | — (not formed) | 100 mol % GaN | 109 |
| 1381 | | | | (Er₂O₃) | | 7160 | 100 mol % GaN | 89 |

TABLE 49

| | Characteristics of | | | Characteristics of the thin film | | |
|---|---|---|---|---|---|---|
| | the sintered compact | | | which formed on the substrate which | | |
| | substrate | | | consists of various sintered compacts | | |
| | Main | | | Thin film which formed | | |
| | ingredients | Average | | beforehand on the substrate | | |
| | [Sintering aids, | surface | | | Formation | |
| | and | roughness | Optical | Composition | method of | |
| Experiment | additive agents] | Ra | transmissivity | of | the | |
| No. | (Firing method) | (nm) | (%) | the thin film | thin film | Crystallized state |
| 1382 | Zirconium | 7.1 | 27 | 100 mol % AlN | Sputter | Amorphous |
| 1383 | dioxide | | | 100 mol % AlN | Sputter | Orientated polycrystal |
| 1384 | [Y₂O₃] | | | 100 mol % AlN | MOCVD | Orientated polycrystal |
| | (Firing in air) | | | | | |
| 1385 | Zirconium | 4.2 | 59 | 100 mol % AlN | Sputter | Amorphous |
| 1386 | dioxide | | | 100 mol % AlN | Sputter | Polycrystal |
| 1387 | [Y₂O₃] | | | 100 mol % AlN | Sputter | Orientated polycrystal |
| 1388 | (Hot press) | | | 100 mol % AlN | MOCVD | Orientated polycrystal |
| 1389 | | | | 100 mol % GaN | MOCVD | Orientated polycrystal |
| 1390 | | | | 100 mol % InN | MOCVD | Orientated polycrystal |
| 1391 | Magnesium | 7.9 | 34 | 100 mol % AlN | Sputter | Amorphous |
| 1392 | oxide | | | 100 mol % AlN | Sputter | Orientated polycrystal |
| 1393 | [no additive] | | | 100 mol % AlN | Sputter | Orientated polycrystal |
| | (Firing in air) | | | | | |
| 1394 | Magnesium | 4.4 | 83 | 100 mol % AlN | Sputter | Amorphous |
| 1395 | oxide | | | 100 mol % AlN | Sputter | Polycrystal |
| 1396 | [CaO + Y₂O₃] | | | 100 mol % AlN | Sputter | Orientated polycrystal |
| 1397 | (Firing in air) | | | 100 mol % AlN | MOCVD | Orientated polycrystal |
| 1398 | | | | 100 mol % AlN | Sputter | Orientated polycrystal |
| 1399 | | | | 100 mol % GaN | MOCVD | Orientated polycrystal |
| 1400 | | | | 100 mol % InN | MOCVD | Orientated polycrystal |
| 1401 | Magnesium | 8.4 | 32 | 100 mol % AlN | Sputter | Amorphous |
| 1402 | aluminate | | | 100 mol % AlN | Sputter | Orientated polycrystal |
| 1403 | [no additive] | | | 100 mol % AlN | Sputter | Orientated polycrystal |
| | (Firing in air) | | | | | |
| 1404 | Magnesium | 5.7 | 79 | 100 mol % AlN | Sputter | Amorphous |
| 1405 | aluminate | | | 100 mol % AlN | Sputter | Polycrystal |
| 1406 | [CaO + Y₂O₃] | | | 100 mol % AlN | Sputter | Orientated polycrystal |
| 1407 | (Firing in | | | 100 mol % AlN | MOCVD | Orientated polycrystal |
| 1408 | hydrogen) | | | 100 mol % AlN | Sputter | Orientated polycrystal |
| 1409 | | | | 100 mol % GaN | MOCVD | Orientated polycrystal |
| 1410 | | | | 100 mol % InN | MOCVD | Orientated polycrystal |
| 1411 | Yttrium oxide | 6.9 | 42 | 100 mol % AlN | Sputter | Amorphous |
| 1412 | [no additive] | | | 100 mol % AlN | Sputter | Orientated polycrystal |
| 1413 | (Firing in air) | | | 100 mol % AlN | Sputter | Orientated polycrystal |
| 1414 | Yttrium oxide | 7.6 | 82 | 100 mol % AlN | Sputter | Amorphous |
| 1415 | [Dy₂O₃ + Ho₂O₃] | | | 100 mol % AlN | Sputter | Polycrystal |
| 1416 | (Firing in | | | 100 mol % AlN | Sputter | Orientated polycrystal |
| 1417 | hydrogen) | | | 100 mol % AlN | MOCVD | Orientated polycrystal |
| 1418 | | | | 100 mol % GaN | MOCVD | Orientated polycrystal |
| 1419 | | | | 100 mol % GaN | MOCVD | Orientated polycrystal |
| 1420 | | | | 100 mol % InN | MOCVD | Orientated polycrystal |

| | Characteristics of | | |
|---|---|---|---|
| | the thin film which formed | | |
| | on the substrate which consists | | |
| | of various sintered compacts | | |
| | Thin film | Thin film which formed | |
| | which formed | furthermore on the thin film | |
| | beforehand on | which formed beforehand on | |
| | the substrate | the substrate | |
| | Half width of | | Half width of |
| | the (002) Xray | | the (002) Xray |
| | diffraction | Composition | diffraction |
| Experiment | rocking curve | of | rocking curve |
| No. | (second) | the thin film | (second) |
| 1382 | — | 100 mol % AlN | 187 |
| 1383 | 9670 | 100 mol % AlN | 180 |
| 1384 | 7970 | 100 mol % GaN | 163 |
| 1385 | — | 100 mol % AlN | 137 |
| 1386 | — | 100 mol % AlN | 138 |
| 1387 | 7820 | 100 mol % AlN | 133 |
| 1388 | 6570 | 100 mol % GaN | 118 |
| 1389 | 6800 | 100 mol % GaN | 120 |
| 1390 | 7090 | 100 mol % GaN | 122 |
| 1391 | — | 100 mol % AlN | 185 |
| 1392 | 9420 | 100 mol % AlN | 171 |
| 1393 | 9240 | 100 mol % GaN | 166 |
| 1394 | — | 100 mol % AlN | 139 |
| 1395 | — | 100 mol % AlN | 144 |
| 1396 | 7880 | 100 mol % AlN | 119 |
| 1397 | 6940 | 100 mol % GaN | 120 |
| 1398 | 7730 | 50 mol % GaN + | 122 |
| | | 50 mol % InN | |
| 1399 | 6950 | 100 mol % GaN | 125 |
| 1400 | 7170 | 100 mol % GaN | 126 |
| 1401 | — | 100 mol % AlN | 191 |
| 1402 | 9440 | 100 mol % AlN | 157 |
| 1403 | 9620 | 100 mol % GaN | 154 |
| 1404 | — | 100 mol % AlN | 144 |
| 1405 | — | 100 mol % AlN | 149 |
| 1406 | 8590 | 100 mol % AlN | 134 |
| 1407 | 7160 | 100 mol % GaN | 124 |
| 1408 | 7970 | 50 mol % AlN + | 128 |
| | | 50 mol % GaN | |
| 1409 | 7140 | 100 mol % GaN | 122 |
| 1410 | 7310 | 100 mol % GaN | 129 |
| 1411 | — | 100 mol % AlN | 177 |
| 1412 | 9330 | 100 mol % AlN | 152 |
| 1413 | 9410 | 100 mol % GaN | 155 |
| 1414 | — | 100 mol % AlN | 139 |
| 1415 | — | 100 mol % AlN | 141 |
| 1416 | 7760 | 100 mol % AlN | 126 |
| 1417 | 6510 | 100 mol % GaN | 115 |
| 1418 | 6740 | 100 mol % AlN | 112 |
| 1419 | 6690 | 100 mol % GaN | 117 |
| 1420 | 7170 | 100 mol % GaN | 121 |

TABLE 50

| | Characteristics of the substrate which consists of a sintered compact which comprises an aluminum nitride as | | | | | | | | | | | |
|---|---|---|---|---|---|---|---|---|---|---|---|---|
| | the main ingredients and used for light emitting device production | | | | | | | | | | | |
| | Characteristics of the | | | | | | | | | | | |
| | substrate which consists of a | | | | | | | | | | | |
| | sintered compact which comprises | | | | | | | | | | | |
| | an aluminum nitride as the | | | | Characteristics of the | | | | | Characteristics of | | |
| | main ingredients | | | | thin film which formed on the substrate | | | | | the light emitting device | | |
| | Used AlN | | | | 1st layer | | | 2nd layer | | which produced | | |
| Ex- | substrates | AlN | Optical | Thin film | Thin | Crystal- | Half width of | Thin | Half width of | Actu- | Lumi- | |
| peri- | (Experiment | content | transmis- | conduc- | film | lized | the rocking | film | the rocking | ating | nescence | Luminou |
| ment | No. which | (volume | sivity | tivity | compo- | state | curve | compo- | curve | current | output | efficiency |
| No. | produced) | %) | (%) | material | sition | *6) | (second) | sition | (second) | (mA) | (mW) | (%) |
| 1421 | 47 | 99.0 | 25 | none | none | — | — | none | — | 480 | 270 | 15.6 |
| 1422 | | | | none | AlN | A | — | none | — | 490 | 310 | 17.6 |
| 1423 | | | | none | AlN | P | — | none | — | 470 | 290 | 17.1 |
| 1424 | | | | none | AlN | O | 7790 | none | — | 480 | 320 | 18.5 |
| 1425 | | | | none | AlN | S | 181 | none | — | 490 | 300 | 17.0 |
| 1426 | | | | none | AlN | A | — | AlN | 89 | 480 | 380 | 22 |
| 1427 | | | | none | AlN | P | — | AlN | 93 | 480 | 360 | 21 |
| 1428 | | | | none | AlN | O | 8060 | AlN | 92 | 490 | 420 | 24 |
| 1429 | | | | none | AlN | S | 187 | AlN | 97 | 500 | 360 | 20 |
| 1430 | 49 | 96.7 | 34 | none | AlN | O | 7640 | AlN | 79 | 490 | 440 | 25 |
| 1431 | | | | W | AlN | O | 7430 | AlN | 86 | 490 | 440 | 26 |
| 1432 | | | | *4) | AlN | O | 7210 | AlN | 90 | 510 | 510 | 28 |
| 1433 | | | | *5) | AlN | O | 7710 | AlN | 88 | 500 | 560 | 31 |
| 1434 | | | | Ru | AlN | O | 7350 | AlN | 94 | 490 | 480 | 27 |
| 1435 | | | | Rh | GaN | O | 4870 | AlN | 93 | 500 | 490 | 27 |
| 1436 | | | | Pd | AlN | O | 7990 | GaN | 92 | 500 | 500 | 28 |
| 1437 | | | | Os | AlN | O | 7830 | AlN | 94 | 500 | 520 | 29 |
| 1438 | | | | Ir | AlN | O | 7760 | GaN | 87 | 490 | 510 | 29 |
| 1439 | | | | Pt | AlN | O | 8140 | GaN | 91 | 490 | 480 | 27 |
| 1440 | | | | Ni | AlN | O | 7070 | AlN | 83 | 480 | 450 | 26 |
| 1441 | 60 | 99.0 | 17 | none | AlN | O | 8120 | AlN | 88 | 480 | 270 | 15.6 |
| 1442 | 106 | 99.8 | 54 | none | GaN | A | — | none | — | 510 | 590 | 32 |
| 1443 | | | | none | AlN | O | 7940 | AlN | 86 | 500 | 670 | 37 |
| 1444 | 108 | 99.8 | 74 | none | AlN | O | 7830 | AlN | 84 | 520 | 950 | 51 |
| 1445 | 110 | 97.0 | 67 | none | AlN | O | 7890 | GaN | 86 | 520 | 820 | 44 |
| 1446 | 259 | *2) | 81 | none | AlN | O | 7470 | AlN | 81 | 560 | 1070 | 53 |
| 1447 | 269 | *2) | 86 | none | AlN | O | 7390 | GaN | 82 | 550 | 1110 | 56 |
| 1448 | 279 | *2) | 85 | none | AlN | O | 7420 | AlN | 80 | 530 | 1070 | 56 |
| 1449 | 284 | *2) | 88 | none | AlN | O | 7520 | AlN | 81 | 540 | 1210 | 62 |
| 1450 | 387 | 99.5 | 46 | none | AlN | O | 7760 | AlN | 87 | 530 | 550 | 29 |
| 1451 | 425 | 98.0 | 6.9 | none | AlN | O | 7240 | AlN | 87 | 490 | 290 | 16.4 |
| 1452 | 433 | 70.0 | 0.8 | none | AlN | O | 6970 | GaN | 89 | 490 | 280 | 15.6 |
| 1453 | 887 | 25.0 | 0.0 | none | AlN | O | 7150 | AlN | 89 | 480 | 220 | 12.7 |
| 1454 | 73 *1) | 96.0 | 32 | Mo | AlN | O | 7760 | AlN | 94 | 500 | 380 | 21 |
| 1455 | 80 *1) | 96.7 | 36 | W | GaN | O | 4560 | GaN | 91 | 500 | 470 | 26 |
| | | | | | *7) | | | *7) | | | | |
| 1456 | 311 *1) | *3) | 82 | none | GaN | O | 4620 | GaN | 89 | 520 | 1010 | 54 |
| | | | | | *7) | | | *7) | | | | |
| 1457 | Sapphire substrate | | 92 | none | none | — | — | none | — | 440 | 106 | 6.7 |
| 1458 | 49 | 96.7 | 34 | none | GaN | O | 4540 | AlN | 89 | 480 | 380 | 22 |
| 1459 | | | | Ti | AlN | O | 7420 | GaN | 93 | 510 | 420 | 23 |
| 1460 | 108 | 99.8 | 74 | none | AlN | O | 7830 | AlN | 84 | 550 | 870 | 44 |
| 1461 | 110 | 97.0 | 67 | none | none | — | — | none | — | 540 | 820 | 42 |
| 1462 | 265 | *2) | 86 | none | AlN | O | 7750 | AlN | 82 | 530 | 950 | 50 |
| 1463 | 279 | *2) | 85 | none | AlN | O | 7420 | AlN | 80 | 540 | 910 | 47 |
| 1464 | 284 | *2) | 88 | none | AlN | O | 7510 | GaN | 84 | 520 | 950 | 51 |
| 1465 | 80 *1) | 96.7 | 36 | Cr | AlN | O | 7230 | AlN | 88 | 490 | 410 | 23 |
| 1466 | 311 *1) | *3) | 82 | none | GaN | O | 4620 | GaN | 89 | 510 | 860 | 47 |
| | | | | | *7) | | | *7) | | | | |

| | | | | | | | | | | | |
|---|---|---|---|---|---|---|---|---|---|---|---|
| 1467 | Sapphire substrate | 92 | none | none | — | — | none | — | 420 | 82 | 5.4 |

*1) Conduction via is formed.
*2) AlN single phase (Additives have vaporized and it is almost AlN 100%. Details about composition are shown in Table 11.).
*3) AlN single phase (Additives have vaporized and it is almost AlN 100%. Additive Y, Ca ingredient is 0.5 ppm or less, respectively.).
*4) It is the W/Cu alloy which has composition of, tungsten: 90 weight %, copper: 10 weight %.
*5) It is the W/Cu alloy which has composition of, tungsten: 70 weight %, copper: 30 weight %.
*6) Crystallized state of the thin film of the 1st layer which formed beforehand on the substrate was shown with, Amorphous: A, Polycrystal: P, Orientated polycrystal: O, Single crystal: S, respectively.
*7) It is what has conductivity by doping Si.

TABLE 51

| | Characteristics of the substrate which consists of a sintered compact which comprises various | | | | | | | | | | | |
|---|---|---|---|---|---|---|---|---|---|---|---|---|
| | ceramic materials as the main ingredients and used for light emitting device production | | | | | | | | | | | |
| | | | | | Characteristics of the thin film which | | | | | | | |
| | Characteristics of the substrate which consists of | | | | formed on the substrate | | | | | Characteristics of | | |
| | a sintered compact which comprises various | | | | 1st layer | | | 2nd layer | | the light emitting device | | |
| | ceramic materials as the main ingredients | | | | | | Half width | | Half width | which produced | | |
| | Used substrates | | Composition | Optical | Thin | Crystal- | of the | Thin | of the | Actuat- | Lumi- | |
| Experi- ment No. | Main ingredient | Example which produced | 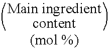 | trans- missivity (%) | film compo- sition | lized state *19) | rocking curve (second) | film compo- sition | rocking curve (second) | ing current (mA) | nescence output (mW) | Luminou efficiency (%) |
| 1468 | Silicon | Example 1 | 98.0 | 0.0 | AlN | A | — | none | — | 470 | 180 | 10.6 |
| 1469 | carbide | Example 8 | *1) | | AlN | O | 9900 | GaN | 147 | 480 | 230 | 13.3 |
| 1470 | Silicon | Example 1 | 96.0 | 0.0 | AlN | O | 11740 | none | — | 460 | 190 | 11.5 |
| 1471 | nitride | Example 8 | *1) | | AlN | O | 10880 | AlN | 163 | 470 | 230 | 13.6 |
| 1472 | Zinc | Example | *2) | 6.9 | AlN | O | 8710 | AlN | 124 | 480 | 240 | 13.9 |
| 1473 | oxide | 30 | ˜100 | 16 | none | — | — | none | — | 460 | 170 | 10.3 |
| 1474 | | | | | AlN | A | — | none | — | 470 | 210 | 12.4 |
| 1475 | | | | | AlN | P | — | none | — | 470 | 190 | 11.2 |
| 1476 | | | | | AlN | O | 9370 | none | — | 470 | 220 | 13.0 |
| 1477 | | | | | AlN | S | 255 | none | — | 470 | 200 | 11.8 |
| 1478 | | | | | AlN | A | — | AlN | 143 | 480 | 250 | 14.5 |
| 1479 | | | | | AlN | P | — | AlN | 145 | 480 | 240 | 13.9 |
| 1480 | | | | | AlN | O | 9430 | AlN | 136 | 480 | 260 | 15.0 |
| 1481 | | | | | AlN | S | 261 | AlN | 186 | 480 | 250 | 14.5 |
| 1482 | | | *4) | 24 | AlN | O | 7620 | AlN | 97 | 480 | 290 | 16.8 |
| 1483 | | | *5) | 36 | AlN | O | 7650 | GaN | 93 | 490 | 330 | 18.7 |
| 1484 | | | *6) | 44 | AlN | O | 7540 | AlN | 93 | 500 | 470 | 26 |
| 1485 | | | *7) | 56 | AlN | O | 7350 | AlN | 86 | 490 | 550 | 31 |
| 1486 | | | | | AlN | O | 7320 | GaN | 88 | 510 | 510 | 28 |
| 1487 | | | | | GaN | O | 7180 | AlN | 88 | 500 | 520 | 29 |
| 1488 | | | *8) | 68 | AlN | O | 7520 | AlN | 93 | 490 | 650 | 37 |
| 1489 | | | *9) | 75 | AlN | O | 7510 | AlN | 92 | 520 | 860 | 46 |
| 1490 | | | | | GaN | O | 6790 | GaN | 89 | 510 | 790 | 43 |
| | | | | | *20) | | | *20) | | | | |
| 1491 | | | *10) | 84 | AlN | O | 7470 | AlN | 87 | 540 | 1070 | 55 |
| 1492 | | | | | GaN | O | 6920 | GaN | 87 | 540 | 970 | 50 |
| | | | | | *20) | | | *20) | | | | |
| 1493 | Beryllium | Example | *11) | 14 | AlN | O | 9670 | AlN | 139 | 470 | 250 14.8 | |
| 1494 | oxide | 31 | *12) | 57 | AlN | O | 7340 | AlN | 89 | 500 | 560 | 31 |
| 1495 | | | *13) | 76 | AlN | O | 7310 | GaN | 91 | 520 | 790 | 42 |
| 1496 | | | *14) | 81 | AlN | O | 7240 | AlN | 88 | 550 | 1030 | 52 |
| 1497 | Aluminum | Example | *15) | 57 | AlN | O | 7260 | AlN | 90 | 490 | 510 | 29 |
| 1498 | oxide | 32 | *16) | 78 | AlN | O | 7240 | AlN | 90 | 500 | 790 | 44 |
| 1499 | | | *17) | 82 | AlN | O | 7070 | AlN | 88 | 510 | 940 | 51 |
| 1500 | Zirconium | Example 1 | 97.0 | 27 | AlN | O | 7970 | GaN | 163 | 460 | 240 | 14.5 |
| 1501 | dioxide | Example | | 59 | GaN | A | — | none | — | 470 | 360 | 21 |
| 1502 | | 33 | | | GaN | O | 6800 | GaN | 120 | 480 | 470 | 27 |
| 1503 | Magne- | Example 1 | ≧99 | 34 | AlN | O | 9420 | AlN | 171 | 490 | 330 | 18.7 |
| 1504 | sium | | *1) | | AlN | O | 9240 | GaN | 166 | 490 | 320 | 18.1 |
| 1505 | oxide | Example | 98.0 | 83 | AlN | A | — | AlN | 139 | 540 | 930 | 48 |
| 1506 | | 33 | *1) | | AlN | O | 7880 | AlN | 119 | 540 | 990 | 51 |
| 1507 | Magne- | Example 1 | ≧99 | 32 | AlN | O | 9470 | none | — | 480 | 270 | 15.6 |
| 1508 | sium | | *1) | | AlN | O | 9620 | GaN | 154 | 490 | 330 | 18.7 |
| 1509 | aluminate | Example | | 81 AlN | O | 8590 | AlN | 134 | 530 | 960 | 50 | |
| 1510 | | 33 | | | AlN | O | 7160 | GaN | 124 | 540 | 870 | 45 |
| 1511 | Yitrium | Example | *18) | 42 | AlN | O | 9330 | AlN | 152 | 490 | 410 | 23 |
| 1512 | oxide | 33 | | | AlN | O | 9410 | GaN | 155 | 500 | 400 | 22 |
| 1513 | | | 99.5 | 83 | AlN | O | 6510 | GaN | 115 | 520 | 880 | 47 |
| 1514 | | | *1) | | AlN | O | 7760 | AlN | 126 | 540 | 990 | 51 |

*1) Shown by weight %.
*2): 99.0 (produced in Experiment No. 1195).
*3): Not using sintereng aids, but produced only with the raw material (produced in Experiment No. 1150-1151).
*4): 99.992 (produced in Experiment No. 1156).
*5): 99.9 (produced in Experiment No. 1161).
*6): 99.7 (produced in Experiment No. 1163).
*7): 97.0 (produced in Expeciment No. 1167-1179).
*8): 99.93 (produced in Experiment No. 1219).
*9): 99.66 (produced in Experiment No. 1236-1237).
*10): 96.96 (produced in Experiment No. 1240-1241).
*11): 100 (produced in Experiment No. 1263).
*12): 99.55 (produced in Experiment No. 1277).
*13): 99.51 (produced in Experiment No. 1313).
*14): 99.51 (produced in Experiment No. 1307).
*15): 98.80 (produced in Experiment No. 1337).
*16): 98.76 (produced in Experiment No. 1379).
*17): 98.76 (produced in Experiment No. 1377).
*18) Not using sintering aids, and produced only with a raw material (produced in Experiment No. 1412-1413).
*19) Crystallized state of the thin film of the 1st layer which formed beforehand on the substrate was shown with, Amorphous: A, Polycrystal: P, Orientated polycrystal: O, Single crystal: S, respectively.
*20) It is what has conductivity by doping Si.

(Mode of the 1st Aspect of this Invention)

As mentioned above, the 1 st aspect of this invention is related with, 1) the substrate for forming the thin film which comprises as the main ingredients a gallium nitride, an indium nitride, and an aluminum nitride, 2) material of the above-mentioned substrate for thin film formation, 3) the thin film substrate on which the thin film which comprises as the main ingredients a gallium nitride, an indium nitride, and an aluminum nitride was formed, 4) the optical waveguide constituted by the thin film which comprises as the main ingredients a gallium nitride, an indium nitride, and an aluminum nitride, 5) the light emitting device constituted by the thin film which comprises as the main ingredients a gallium nitride, an indium nitride, and an aluminum nitride.

If it says in detail, it is related with, 1) the substrate for forming the thin film which comprises as the main ingredients a gallium nitride, an indium nitride, and an aluminum nitride, 2) the manufacture method of the substrate for thin film formation using the sintered compact which comprises an aluminum nitride as the main ingredients, 3) the sintered compact which comprises an aluminum nitride as the main ingredients and which has optical permeability, 4) the sintered compact which comprises a zinc oxide as the main ingredients and which has optical permeability, 5) the thin film substrate on which the thin film which comprises as the main ingredients a gallium nitride, an indium nitride, and an aluminum nitride was formed, 6) the manufacture method of a thin film substrate, 7) the optical waveguide constituted by the thin film which comprises as the main ingredients a gallium nitride, an indium nitride, and an aluminum nitride, 8) the light emitting device constituted by the thin film which comprises as the main ingredients a gallium nitride, an indium nitride, and an aluminum nitride.

As explained until now, the mode of the 1st aspect of this invention includes the following contents.

Details are explained about the mode of the 1 st aspect of this invention below.

Item 1. A substrate for thin film formation in which a thin film comprises at least one or more materials selected from a gallium nitride, an indium nitride, and an aluminum nitride as the main ingredients, and the substrate consists of a sintered compact which comprises an aluminum nitride as the main ingredients.

Item 2. The substrate for thin film formation as described in Item 1, wherein the thin film which comprises as the main ingredients at least one or more materials selected from a gallium nitride, an indium nitride, and an aluminum nitride has at least one of the crystallized states selected from a single crystal, an amorphous state, a polycrystal, and an orientated polycrystal.

Item 3. The substrate for thin film formation as described in Item 1 or 2, wherein at least a part of the formed thin film which comprises as the main ingredients at least one or more materials selected from a gallium nitride, an indium nitride, and an aluminum nitride is a single crystal.

Item 4. The substrate for thin film formation as described in Item 1, 2, or 3, wherein the sintered compact which comprises an aluminum nitride as the main ingredients has optical permeability.

Item 5. The substrate for thin film formation as described in Item 1, 2, 3, or 4, wherein the sintered compact which comprises an aluminum nitride as the main ingredients is the optical transmissivity not less than 1%.

Item 6. The substrate for thin film formation as described in Item 1, 2, 3, 4, or 5, wherein the sintered compact which comprises an aluminum nitride as the main ingredients is the optical transmissivity not less than 5%.

Item 7. The substrate for thin film formation as described in Item 1, 2, 3, 4, 5, or 6, wherein the sintered compact which comprises an aluminum nitride as the main ingredients is the optical transmissivity not less than 10%.

Item 8. The substrate for thin film formation as described in Item 1, 2, 3, 4, 5, 6, or 7, wherein the sintered compact which comprises an aluminum nitride as the main ingredients is the optical transmissivity not less than 20%.

Item 9. The substrate for thin film formation as described in Item 1, 2, 3, 4, 5, 6, 7, or 8, wherein the sintered compact which comprises an aluminum nitride as the main ingredients is the optical transmissivity not less than 30%.

Item 10. The substrate for thin film formation as described in Item 1, 2, 3, 4, 5, 6, 7, 8 or 9, wherein the sintered compact which comprises an aluminum nitride as the main ingredients is the optical transmissivity not less than 40%.

Item 11. The substrate for thin film formation as described in Item 1, 2, 3, 4, 5, 6, 7, 8, 9, or 10, wherein the sintered compact which comprises an aluminum nitride as the main ingredients is the optical transmissivity not less than 50%.

Item 12. The substrate for thin film formation as described in Item 1, 2, 3, 4, 5, 6, 7, 8, 9, 10, or 11, wherein the sintered compact which comprises an aluminum nitride as the main ingredients is the optical transmissivity not less than 60%.

Item 13. The substrate for thin film formation as described in Item 1, 2, 3, 4, 5, 6, 7, 8, 9, 10, 11, or 12, wherein the sintered compact which comprises an aluminum nitride as the main ingredients is the optical transmissivity not less than 80%.

Item 14. The substrate for thin film formation as described in Item 1, 2, 3, 4, 5, 6, 7, 8, 9, 10, 11, 12, or 13, wherein the sintered compact which comprises an aluminum nitride as the main ingredients is the optical transmissivity not less than 85%.

Item 15. The substrate for thin film formation as described in Item 1, 2, or 3, wherein the optical transmissivity of the sintered compact which comprises an aluminum nitride as the main ingredients is smaller than 1%.

Item 16. The substrate for thin film formation as described in Item 15, wherein the optical transmissivity of the sintered compact which comprises an aluminum nitride as the main ingredients is 0%.

Item 17. The substrate for thin film formation as described in Item 4, 5, 6, 7, 8, 9, 10, 11, 12, 13, 114, 15, or 16, wherein the optical permeability or optical transmissivity is a thing in the light of the range of 200 nm-800 nm wavelength at least.

Item 18. The substrate for thin film formation as described in Item 1, 2, 3, 4, 5, 6, 7, 8, 9, 10, 11, 12, 13, 14, 15, 16, or 17, wherein the sintered compact which comprises an aluminum nitride as the main ingredients contains an aluminum nitride not less than 20 volume %.

Item 19. The substrate for thin film formation as described in Item 18, wherein the sintered compact which comprises an aluminum nitride as the main ingredients contains an aluminum nitride not less than 50 volume %.

Item 20. The substrate for thin film formation as described in Item 1, 2, 3, 4, 5, 6, 7, 8, 9, 10, 11, 12, 13, 14, 15, 16, 17, 18, or 19, wherein the sintered compact which comprises an aluminum nitride as the main ingredients contains at least one or more ingredients selected from a rare earth element or an alkaline earth metal not more than 80 volume % by oxide conversion.

Item 21. The substrate for thin film formation as described in Item 20, wherein the sintered compact which comprises an aluminum nitride as the main ingredients contains at least one or more ingredients selected from a rare earth element or an alkaline earth metal not more than 50 volume % by oxide conversion.

Item 22. The substrate for thin film formation as described in Item 20, or 21, wherein the sintered compact which comprises an aluminum nitride as the main ingredients contains at least one or more ingredients selected from a rare earth element or an alkaline earth metal not more than 25 volume % by oxide conversion.

Item 23. The substrate for thin film formation as described in Item 20, 21, or 22, wherein the sintered compact which comprises an aluminum nitride as the main ingredients contains simultaneously at least one or more ingredients selected from a rare earth element and at least one or more ingredients selected from an alkaline earth metal.

Item 24. The substrate for thin film formation as described in Item 1, 2, 3, 4, 5, 6, 7, 8, 9, 10, 11, 12, 13, 14, 15, 16, 17, 18, 19, 20, 21, 22, or 23, wherein the sintered compact which comprises an aluminum nitride as the main ingredients contains at least one or more ingredients selected from an alkaline metal or silicon not more than 50 volume % by oxide conversion.

Item 25. The substrate for thin film formation as described in Item 24, wherein the sintered compact which comprises an aluminum nitride as the main ingredients contains at least one or more ingredients selected from an alkaline metal or silicon not more than 30 volume % by oxide conversion.

Item 26. The substrate for thin film formation as described in Item 24 or 25, wherein the sintered compact which comprises an aluminum nitride as the main ingredients contains at least one or more ingredients selected from an alkaline metal or silicon not more than 20 volume % by oxide conversion.

Item 27. The substrate for thin film formation as described in Item 24, 25, or 26, wherein the sintered compact which comprises an aluminum nitride as the main ingredients contains at least one or more ingredients selected from an alkaline metal or silicon not more than 10 volume % by oxide conversion.

Item 28. The substrate for thin film formation as described in Item 20, 21, 22, 23, 24, 25, 26, or 27, wherein the sintered compact which comprises an aluminum nitride as the main ingredients contains at least one or more ingredients selected from an alkaline metal or silicon and contains simultaneously at least one or more ingredients selected from a rare earth element or an alkaline earth metal.

Item 29. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, or 28, wherein the sintered compact which comprises an aluminum nitride as the main ingredients contains at least one or more ingredients selected from Mo, W, V (vanadium), Nb, Ta, Ti, and carbon not more than 80 volume % by element conversion.

Item 30. The substrate for thin film formation as described in Item 29, wherein the sintered compact which comprises an aluminum nitride as the main ingredients contains at least one or more ingredients selected from Mo, W, V (vanadium), Nb, Ta, Ti, and carbon not more than 50 volume % by element conversion.

Item 31. The substrate for thin film formation as described in Item 29, or 30, wherein the sintered compact which comprises an aluminum nitride as the main ingredients contains at least one or more ingredients selected from Mo, W, V (vanadium), Nb, Ta, Ti, and carbon not more than 25 volume % by element conversion.

Item 32. The substrate for thin film formation as described in Item 20, 21, 22, 23, 29, 30, or 31, wherein the sintered compact which comprises an aluminum nitride as the main ingredients contains at least one or more ingredients selected from Mo, W, V (vanadium), Nb, Ta, Ti, and carbon and contains simultaneously at least one or more ingredients selected from a rare earth element or an alkaline-earth metal.

Item 33. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, or 32, wherein the sintered compact which comprises an aluminum nitride as the main ingredients contains a transition metal ingredient not more than 80 weight % by element conversion other than a rare earth element and Mo, W, V (vanadium), Nb, Ta, and Ti.

Item 34. The substrate for thin film formation as described in Item 33, wherein the sintered compact which comprises an aluminum nitride as the main ingredients contains a transition metal ingredient not more than 50 weight % by element conversion other than a rare earth element and Mo, W, V (vanadium), Nb, Ta, and Ti.

Item 35. The substrate for thin film formation as described in Item 33 or 34, wherein the sintered compact which comprises an aluminum nitride as the main ingredients contains a transition metal ingredient not more than 30 weight % by element conversion other than a rare earth element and Mo, W, V, Nb, Ta, and Ti.

Item 36. The substrate for thin film formation as described in Item 20, 21, 22, 23, 33, 34, or 35, wherein the sintered compact which comprises an aluminum nitride as the main ingredients contains a transition metal ingredient other than a rare earth element and Mo, W, V, Nb, Ta, and Ti and contains simultaneously at least one or more ingredients selected from a rare earth element or an alkaline-earth metal.

Item 37. The substrate for thin film formation as described in Item 33, 34, 35, or 36, wherein the transition metal ingredient other than a rare earth element and Mo, W, V, Nb, Ta, and Ti is at least one or more elements selected from iron, nickel, chromium, manganese, zirconium, hafnium, cobalt, copper, and zinc.

Item 38. The substrate for thin film formation as described in Item 1, 2, 3,4, 5, 6, 7, 8, 9, 10, 11, 12, 13, 14, 15, 16, 17, 18, 19, 20,21,22,23,24,25,26, 27,28,29, 30, 31, 32, 33, 34, 35, 36, or 37, wherein the sintered compact which comprises an aluminum nitride as the main ingredients is oxygen content not more than 30 weight %.

Item 39. The substrate for thin film formation as described in Item 38, wherein the sintered compact which comprises an aluminum nitride as the main ingredients is oxygen content not more than 25 weight %.

Item 40. The substrate for thin film formation as described in Item 38, or 39, wherein the sintered compact which comprises an aluminum nitride as the main ingredients is oxygen content not more than 10 weight %.

Item 41. The substrate for thin film formation as described in Item 20, 21, 22, 23, 38, 39, or 40, wherein the sintered compact which comprises an aluminum nitride as the main ingredients contains oxygen and contains simultaneously at least one or more ingredients selected from a rare earth element or an alkaline-earth metal.

Item 42. The substrate for thin film formation as described in Item 1, 2, 3, 4, 5, 6, 7, 8, 9, 10, 11, 12, 13, 14, 15, 16, 17, 18, 19,20, 21,22, 23, 24, 25, 26,27, 28,29, 30, 31, 32, 33, 34, 35, 36, 37, 38, 39, 40, or 41, wherein the sintered compact which comprises an aluminum nitride as the main ingredients is ALON content not more than 80%.

Item 43. The substrate for thin film formation as described in Item 42, wherein the sintered compact which comprises an aluminum nitride as the main ingredients is ALON content not more than 50%.

Item 44. The substrate for thin film formation as described in Item 42 or 43, wherein the sintered compact which comprises an aluminum nitride as the main ingredients is ALON content not more than 20%.

Item 45. The substrate for thin film formation as described in Item 20, 21, 22, 23, 42, 43, or 44, wherein the sintered compact which comprises an aluminum nitride as the main ingredients contains ALON and contains simultaneously at least one or more ingredients selected from a rare earth element or an alkaline-earth metal.

Item 46. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, or 45, wherein the sintered compact which comprises an aluminum nitride as the main ingredients is thermal conductivity not less than 50 W/mK in room temperature.

Item 47. The substrate for thin film formation as described in Item 46, wherein the sintered compact which comprises an aluminum nitride as the main ingredients is thermal conductivity not less than 100 W/mK in room temperature.

Item 48. The substrate for thin film formation as described in Item 46, or 47, wherein the sintered compact which comprises an aluminum nitride as the main ingredients is thermal conductivity not less than 150 W/mK in room temperature.

Item 49. The substrate for thin film formation as described in Item 46, 47, or 48, wherein the sintered compact which comprises an aluminum nitride as the main ingredients is thermal conductivity not less than 170 W/mK in room temperature.

Item 50. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, or 49, wherein the sintered compact which comprises an aluminum nitride as the main ingredients contains an aluminum nitride not less than 95 volume %.

Item 51. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, wherein the sintered compact which comprises an aluminum nitride as the main ingredients contains at least one or more ingredients selected from a rare earth element and an alkaline-earth metal not more than 0.5 weight % in total by element conversion and contains oxygen not more than 0.9 weight %,

Item 52. The substrate for thin film formation as described in Item 51, wherein the sintered compact which comprises an aluminum nitride as the main ingredients contains at least one or more ingredients selected from a rare earth element and an alkaline-earth metal not more than 0.2 weight % in total by element conversion and contains oxygen not more than 0.5 weight %.

Item 53. The substrate for thin film formation as described in Item 51 or 52, wherein the sintered compact which comprises an aluminum nitride as the main ingredients contains at least one or more ingredients selected from a rare earth element and an alkaline-earth metal not more than 0.05 weight % in total by element conversion and contains oxygen not more than 0.2 weight %.

Item 54. The substrate for thin film formation as described in Item 51, 52, or 53, wherein the sintered compact which comprises an aluminum nitride as the main ingredients contains at least one or more ingredients selected from a rare earth element and an alkaline-earth metal not more than 0.02 weight % in total by element conversion and contains oxygen not more than 0.1 weight %.

Item 55. The substrate for thin film formation as described in Item 51, 52, 53, or 54, wherein the sintered compact which comprises an aluminum nitride as the main ingredients contains at least one or more ingredients selected from a rare earth element and an alkaline-earth metal not more than 0.005 weight % in total by element conversion and contains oxygen not more than 0.05 weight %.

Item 56. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55, wherein the sintered compact which comprises an aluminum nitride as the main ingredients contains at least one or more ingredients selected from an alkaline metal or silicon not more than 0.2 weight % in total by element conversion and contains oxygen not more than 0.9 weight %.

Item 57. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, or 56, wherein the sintered compact which comprises an aluminum nitride as the main ingredients contains at least one or more ingredients selected from Mo, W, V (vanadium), Nb, Ta, Ti, and carbon not more than 0.2 weight % in total by element conversion and contains oxygen not more than 0.9 weight %.

Item 58. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, or 57, wherein the sintered compact which comprises an aluminum nitride as the main ingredients contains at least one or more ingredients selected from Fe, Ni, Co, Mn, Cr, Zr, Hf, Cu, Zn not more than 0.2 weight % in total by element conversion and contains oxygen not more than 0.9 weight %.

Item 59. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, or 58, wherein the sintered compact which comprises an aluminum nitride as the main ingredients contains AlN not less than 95% as a crystal phase.

Item 60. The substrate for thin film formation as described in Item 59, wherein the sintered compact which comprises an aluminum nitride as the main ingredients contains AlN not less than 98% as a crystal phase.

Item 61. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60, wherein the sintered compact which comprises an aluminum nitride as the main ingredients consists of a single phase of AlN substantially.

Item 62. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, or 61, wherein the sintered compact which comprises an aluminum nitride as the main ingredients is thermal conductivity not less than 200 W/mK in room temperature.

Item 63. The substrate for thin film formation as described in Item 62, wherein the sintered compact which comprises an aluminum nitride as the main ingredients is thermal conductivity not less than 220 W/mK in room temperature.

Item 64. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, or 63, wherein the sintered compact which comprises an aluminum nitride as the main ingredients is relative density not less than 95%.

Item 65. The substrate for thin film formation,, wherein the sintered compact which comprises an aluminum nitride as the main ingredients is relative density not less than 98%, as described in Item 64.

Item 66. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65, wherein the sintered compact which comprises an aluminum nitride as the main ingredients is an average pore size not more than 1 μm.

Item 67. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65, wherein the sintered compact which comprises an aluminum nitride as the main ingredients is the thing whose size of an aluminum nitride particle is an average of not less than 1 μm.

Item 68. The substrate for thin film formation as described in Item 67, wherein the size of an aluminum nitride particle is an average of not less than 5 μm.

Item 69. The substrate for thin film formation as described in Item 67, or 68, wherein the size of an aluminum nitride particle is an average of not less than 8 μm.

Item 70. The substrate for thin film formation as described in Item 67, 68, or 69, wherein the size of an aluminum nitride particle is an average of not less than 15 μm.

Item 71. The substrate for thin film formation as described in Item 68, 69, or 70, wherein the size of an aluminum nitride particle is an average of not less than 25 μm.

Item 72. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, or 71, wherein the sintered compact which comprises an aluminum nitride as the main ingredients is the thing whose size of an aluminum nitride particle is an average of not more than 100 μm.

Item 73. The substrate for thin film formation which is a substrate for thin film formation consisting of a sintered compact which comprises an aluminum nitride as the main ingredients, and which is described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, or 72 and is characterized in that the surface of the substrate is a smooth nature not more than 2000 nm as average surface roughness Ra.

Item 74. The substrate for thin film formation as described in Item 73, wherein the surface of the substrate is a smooth nature not more than 1000 nm as average surface roughness Ra

Item 75. The substrate for thin film formation as described in Item 73 or 74, wherein the surface of the substrate is a smooth nature not more than 100 nm as average surface roughness Ra.

Item 76. The substrate for thin film formation as described in Item 73, 74, or 75, wherein the surface of the substrate is a smooth nature not more than 20 nm as average surface roughness Ra.

Item 77. The substrate for thin film formation which is a substrate for thin film formation consisting of a sintered compact which comprises an aluminum nitride as the main ingredients, and which is described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, or 72 and is characterized in that the surface of the substrate is a smooth nature of more than 2000 nm as average surface roughness Ra.

Item 78. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, or 77, wherein the substrate surface is at least one of the states selected from as-fired one (as-fire), lap polish, or specular surface polish.

Item 79. The substrate for thin film formation as described in Item 73, 74, 75, 76, or 78, wherein the substrate surface is a state in which specular surface polish was performed.

Item 80. The substrate for thin film formation which is a substrate for thin film formation consisting of a sintered compact which comprises an aluminum nitride as the main ingredients, and which is described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, or 79 and is characterized in that the thickness of this substrate is not more than 8.0 mm.

Item 81. The substrate for thin film formation as described in Item 80, wherein the thickness of the substrate is not more than 5.0 mm.

Item 82. The substrate for thin film formation as described in Item 80 or 81, wherein the thickness of the substrate is not more than 2.5 mm.

Item 83. The substrate for thin film formation as described in Item 80, 81, or 82, wherein the thickness of the substrate is not more than 1.0 mm.

Item 84. The substrate for thin film formation which is a substrate for thin film formation consisting of a sintered compact which comprises an aluminum nitride as the main ingredients, and which is described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, or 83 and is characterized in that the thickness of this substrate is not less than 0.01 mm.

Item 85. The substrate for thin film formation as described in Item 84, wherein the thickness of the substrate is not less than 0.02 mm.

Item 86. The substrate for thin film formation as described in Item 84 or 85, wherein the thickness of the substrate is not less than 0.05 mm.

Item 87. The substrate for thin film formation as described in Item 84, 85, or 86, wherein the thickness of the substrate is not more than 8.0 mm and the optical transmissivity is not less than 1%.

Item 88. The substrate for thin film formation as described in Item 80, 81, 82, 83, 84, 85, 86, or 87, wherein the thickness of the substrate is not less than 0.01 mm and the optical transmissivity is not less than 40%.

Item 89. The substrate for thin film formation in which a thin film comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, or 88, and the substrate consists of a sintered compact which comprises an aluminum nitride as the main ingredients and which has a conduction via.

Item 90. The substrate for thin film formation in which a thin film comprises at least one or more materials selected from a gallium nitride, an indium nitride, and an aluminum nitride as the main ingredients and was described in Item 89, wherein the substrate consists of a sintered compact which comprises an aluminum nitride as the main ingredients, and the conduction via which connects electrically the up-and-down surface of a substrate exists in the substrate.

Item 91. The substrate for thin film formation as described in Item 89 or 90, wherein the conduction via comprises as the main ingredients at least one or more elements selected from gold, silver, copper, aluminum, iron, cobalt, nickel, ruthenium, rhodium, palladium, osmium, iridium, platinum, molybdenum, tungsten, chromium, titanium, titanium nitride, and zirconium nitride.

Item 92. The substrate for thin film formation as described in Item 89, 90, or 91, wherein the conduction via comprises as the main ingredients at least one or more elements selected from gold, silver, copper, aluminum, iron, cobalt, nickel, ruthenium, rhodium, palladium, osmium, iridium, platinum, molybdenum, tungsten, chromium, titanium, titanium nitride, and zirconium nitride and contains furthermore at least one or more materials selected from an aluminum nitride, a silicon carbide, a silicon nitride, a zinc oxide, a beryllium oxide, an aluminum oxide, a rare earth element compound, and an alkaline-earth-metals compound.

Item 93. The substrate for thin film formation as described in Item 89, 90, 91, or 92, wherein the conduction via consists of material(s) which comprise as the main ingredients at least one or more elements selected from molybdenum, tungsten, copper, titanium nitride, and zirconium nitride.

Item 94. The substrate for thin film formation as described in Item 89, 90, 91, 92, or 93, wherein the conduction via comprises as the main ingredients at least one or more elements selected from molybdenum, tungsten, copper, titanium nitride, and zirconium nitride and contains furthermore at least one or more materials selected from an aluminum nitride, an aluminum oxide, a rare earth element compound, and an alkaline-earth-metals compound.

Item 95. The substrate for thin film formation as described in Item 89, 90, 91, 92, 93, or 94, wherein the conduction via consists of a conductive material whose electric resistivity is not more than 1×10⁻³ Ω·cm in room temperature.

Item 96. The substrate for thin film formation as described in Item 95, wherein the conduction via consists of a conductive material whose electric resistivity is not more than 1×10⁻⁴ Ω·cm in room temperature.

Item 97. The substrate for thin film formation as described in Item 95, or 96, wherein the conduction via consists of a conductive material whose electric resistivity is not more than 1×10⁻⁵ Ω·cm in room temperature.

Item 98. The substrate for thin film formation as described in Item 89, 90, 91, 92, 93, 94, 95, 96, or 97, wherein the size of a conduction via is not more than 500 μm.

Item 99. The substrate for thin film formation as described in Item 98, wherein the size of a conduction via is not more than 250 μm.

Item 100. The substrate for thin film formation as described in Item 98 or 99, wherein the size of a conduction via is not more than 100 μm.

Item 101. The substrate for thin film formation as described in Item 98, 99, or 100, wherein the size of a conduction via is not more than 50 μm.

Item 102. The substrate for thin film formation as described in Item 98, 99, 100, or 101, wherein the size of a conduction via is not more than 25 μm.

Item 103. The substrate for thin film formation as described in Item 89, 90, 91, 92, 93, 94, 95, 96, 97, 98, 99, 100, 101, or 102, wherein the size of a conduction via is not less than 1 μm.

Item 104. The substrate for thin film formation as described in Item 89, 90, 91, 92, 93, 94, 95, 96, 97, 98, 99, 100, 101, 102, or 103, wherein the thin film which comprises as the main ingredients at least one or more materials selected from a gallium nitride, an indium nitride, and an aluminum nitride can form also on the surface of a conduction via.

Item 105. The substrate for thin film formation in which a thin film comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, or 104, and the substrate consists of a sintered compact which comprises an aluminum nitride as the main ingredients and which formed the thin film conductivity material.

Item 106. The substrate for thin film formation as described in Item 105, wherein the thin film conductivity material consists of at least one or more materials selected from metal, alloy, and metal nitride.

Item 107. The substrate for thin film formation as described in Item 105 or 106, wherein the thin film conductivity material consists of material which comprises as the main ingredients at least one or more elements selected from gold, silver, copper, aluminum, iron, cobalt, nickel, a ruthenium, rhodium, palladium, osmium, iridium, platinum, tantalum, molybdenum, tungsten, chromium, titanium, nickel chromium alloy, titanium nitride, zirconium nitride, and tantalum nitride.

Item 108. The substrate for thin film formation as described in Item 105, 106, or 107, wherein the thin film conductivity material is being constituted with at least two or more layers.

Item 109. The substrate for thin film formation as described in Item 105, 106, 107, or 108, wherein the thickness of the thin film conductivity material is not more than 20 μm.

Item 110. The substrate for thin film formation as described in Item 105, 106, 107, 108, or 109, wherein the junction strength between the thin film conductivity material and the thin film which comprises as the main ingredients at least one or more materials selected from a gallium nitride, an indium nitride, and an aluminum nitride is not less than 2 Kg/mm² by perpendicular tension method.

Item 111. The substrate for thin film formation as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, or 110, wherein the sintered compact which comprises an aluminum nitride as the main ingredients and is used as a substrate for forming the thin film that comprises as the main ingredients at least one or more materials selected from a gallium nitride, an indium nitride, and an aluminum nitride is what is obtained by firing the powder compact or sintered compact which comprise an aluminum nitride as the main ingredients for not less than 10 minutes at the temperature not less than 1500 degrees C. in non-oxidizing atmosphere.

Item 112. The substrate for thin film formation as described in Item 111, wherein the sintered compact which comprises an aluminum nitride as the main ingredients and is used as a substrate for forming the thin film that comprises as the main ingredients at least one or more materials selected from a gallium nitride, an indium nitride, and an aluminum nitride is what is obtained by firing the powder compact or sintered compact which comprise an aluminum nitride as the main ingredients for not less than 3 hours at the temperature not less than 1750 degrees C. in non-oxidizing atmosphere.

Item 113. The substrate for thin film formation as described in Item 1, 2, 3, 4, 5, 6, 7, 8, 9, 10, 11, 12, 13, 14, 15, 16, 17, 18, 19, 20,21,22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, or 112, wherein the sintered compact which comprises an aluminum nitride as the main ingredients and is used as a substrate for forming the single crystal thin film that comprises as the main ingredients at least one or more materials selected from a gallium nitride, an indium nitride, and an aluminum nitride is what is obtained by firing the powder compact or sintered compact which comprise an aluminum nitride as the main ingredients and contains at least one or more compounds selected from a rare earth element compound and an alkaline-earth-metals compound for not less than 3 hours at the temperature not less than 1750 degrees C. in non-oxidizing atmosphere and by vaporizing, removing, and decreasing at least a rare earth element compound, an alkaline-earth-metals compound, and oxygen among the ingredients contained.

Item 114. A substrate for thin film formation in which a thin film comprises at least one or more materials selected from a gallium nitride, an indium nitride, and an aluminum nitride as the main ingredients, and the substrate consists of a sintered compact which comprises as the main ingredients a ceramic material which has at least one of the crystal structures selected from a hexagonal system or a trigonal system.

Item 115. The substrate for thin film formation as described in Item 114, wherein the ceramic material which has at least one of the crystal structures selected from a hexagonal system or a trigonal system is at least one of things selected from a silicon carbide, a silicon nitride, a zinc oxide, a beryllium oxide, and an aluminum oxide.

Item 116. The substrate for thin film formation as described in Item 114 or 115, wherein the ceramic material which has at least one of the crystal structures selected from a hexagonal system or a trigonal system consists of a sintered compact which comprises a zinc oxide as the main ingredients.

Item 117. The substrate for thin film formation as described in Item 115 or 116, wherein the sintered compact which comprises a zinc oxide as the main ingredients has optical permeability.

Item 118. The substrate for thin film formation as described in Item 115, 116, or 117, wherein the sintered compact which comprises a zinc oxide as the main ingredients has the optical transmissivity not less than 1%.

Item 119. The substrate for thin film formation as described in Item 118, wherein the sintered compact which comprises a zinc oxide as the main ingredients has the optical transmissivity not less than 10%.

Item 120. The substrate for thin film formation as described in Item 118 or 119, wherein the sintered compact which comprises a zinc oxide as the main ingredients has the optical transmissivity not less than 20%.

Item 121. The substrate for thin film formation as described in Item 118, 119, or 120, wherein the sintered compact which comprises a zinc oxide as the main ingredients has the optical transmissivity not less than 30%.

Item 122. The substrate for thin film formation as described in Item 118, 119, 120, or 121, wherein the sintered compact which comprises a zinc oxide as the main ingredients has the optical transmissivity not less than 40%.

Item 123. The substrate for thin film formation as described in Item 118, 119, 120, 121, or 122, wherein the sintered compact which comprises a zinc oxide as the main ingredients has the optical transmissivity not less than 50%.

Item 124. The substrate for thin film formation as described in Item 118, 119, 120, 121, 122, or 123, wherein the sintered compact which comprises a zinc oxide as the main ingredients has the optical transmissivity not less than 60%.

Item 125. The substrate for thin film formation as described in Item 118, 119, 120, 121, 122, 123, or 124, wherein the sintered compact which comprises a zinc oxide as the main ingredients has the optical transmissivity not less than 80%.

Item 126. The substrate for thin film formation as described in Item 114, 115, or 116, wherein the optical transmissivity of the sintered compact which comprises a zinc oxide as the main ingredients is smaller than 1%.

Item 127. The substrate for thin film formation as described in Item 126, wherein the optical transmissivity of the sintered compact which comprises a zinc oxide as the main ingredients is 0%.

Item 128. The substrate for thin film formation as described in Item 114, 115, 116, 117, 118, 119, 120, 121, 122, 123, 124, 125, 126, or 127, wherein the sintered compact which comprises a zinc oxide as the main ingredients has electrical conductivity.

Item 129. The substrate for thin film formation as described in Item 128, wherein the sintered compact which comprises a zinc oxide as the main ingredients and has conductivity is electric resistivity not more than 1×10² Ω·cm in room temperature.

Item 130. The substrate for thin film formation as described in Item 128 or 129, wherein the sintered compact which comprises a zinc oxide as the main ingredients and has conductivity is electric resistivity not more than 1×10⁰ Ω·cm in room temperature.

Item 131. The substrate for thin film formation as described in Item 128, 129, or 130, wherein the sintered compact which comprises a zinc oxide as the main ingredients and has conductivity is electric resistivity not more than 1×10⁻¹ Ω·cm in room temperature.

Item 132. The substrate for thin film formation as described in Item 128, 129, 130, or 131, wherein the sintered compact which comprises a zinc oxide as the main ingredients and has conductivity is electric resistivity not more than 1×10⁻² Ω·cm in room temperature.

Item 133. The substrate for thin film formation as described in Item 115, 116, 117, 118, 119, 120, 121, 122, 123, 124, 125, 126, 127, 128, 129, 130, 131, or 132, wherein the sintered compact which comprises a zinc oxide as the main ingredients has optical permeability and electrical conductivity.

Item 134. The substrate for thin film formation as described in Item 115, 116, 117, 118, 119, 120, 121, 122, 123, 124, 125, 126, 127, 128, 129, 130, 131, 132, or 133, wherein the sintered compact which comprises a zinc oxide as the main ingredients contains an aluminum ingredient.

Item 135. The substrate for thin film formation as described in Item 115, 116, 117, 118, 119, 120, 121, 122, 123, 124, 125, 126, 127, 128, 129, 130, 131, 132, 133, or 134, wherein the sintered compact which comprises a zinc oxide as the main ingredients contains a zinc oxide ingredient not less than 55.0 mol % by ZnO conversion.

Item 136. The substrate for thin film formation as described in Item 115, 116, 117, 118, 119, 120, 121, 122, 123, 124, 125, 126, 127, 128, 129, 130, 131, 132, 133, 134, or 135, wherein the sintered compact which comprises a zinc oxide as the main ingredients contains an aluminum ingredient not more than 45.0 mol % by Al₂O₃ conversion.

Item 137. The substrate for thin film formation as described in Item 136, wherein the sintered compact which comprises a zinc oxide as the main ingredients contains an aluminum ingredient in the range of 0.001 mol %-45.0 mol % by Al₂O₃ conversion.

Item 138. The substrate for thin film formation as described in Item 136 or 137, wherein the sintered compact which comprises a zinc oxide as the main ingredients contains an aluminum ingredient in the range of 0.005 mol %-45.0 mol % by Al₂O₃ conversion.

Item 139. The substrate for thin film formation as described in Item 136, 137, or 138, wherein the sintered compact which comprises a zinc oxide as the main ingredients contains an aluminum ingredient in the range of 0.02 mol %-45.0 mol % by Al₂O₃ conversion.

Item 140. The substrate for thin film formation as described in Item 136, 137, 138, or 139, wherein the sintered compact which comprises a zinc oxide as the main ingredients contains an aluminum ingredient in the range of 0.08 mol %-35.0 mol % by Al₂O₃ conversion.

Item 141. The substrate for thin film formation as described in Item 115, 116, 117, 118, 119, 120, 121, 122, 123, 124, 125, 126, 127, 128, 129, 130, 131, 132, 133, 134, 135, 136, 137, 138, 139, or 140, wherein the sintered compact which comprises a zinc oxide as the main ingredients contains at least one or more ingredients selected from an alkaline-earth-metals ingredient, a rare earth element ingredient, a transition metal ingredient, and a silicon ingredient.

Item 142. The substrate for thin film formation as described in Item 141, wherein the sintered compact which comprises a zinc oxide as the main ingredients contains at least one or more ingredients selected from a rare earth element ingredient and a transition metal ingredient.

Item 143. The substrate for thin film formation as described in Item 141, or 142, wherein the sintered compact which comprises a zinc oxide as the main ingredients contains at least one or more ingredients selected from a rare earth element ingredient.

Item 144. The substrate for thin film formation as described in Item 143, wherein the sintered compact which comprises a zinc oxide as the main ingredients contains at least one or more ingredients selected from a rare earth element ingredient and has optical permeability.

Item 145. The substrate for thin film formation as described in Item 143 or 144, wherein the sintered compact which comprises a zinc oxide as the main ingredients contains at least one or more ingredients selected from a rare earth element ingredient and has the optical transmissivity not less than 30%.

Item 146. The substrate for thin film formation as described in Item 117, 118, 119, 120, 121, 122, 123, 124, 125, 126, 127, 133, 144, or 145, wherein the optical permeability or optical transmissivity is a thing in the light of the range of 200 nm-800 nm wavelength at least.

Item 147. The substrate for thin film formation as described in Item 141 or 142, wherein the sintered compact which comprises a zinc oxide as the main ingredients contains at least one or more ingredients selected from a transition metal ingredient.

Item 148. The substrate for thin film formation as described in Item 141, 142, 143, 144, 145, or 147, wherein the sintered compact which comprises a zinc oxide as the main ingredients contains at least one or more ingredients selected from a rare earth element ingredient and a transition metal ingredient not more than 10.0 mol % by oxide conversion.

Item 149. The substrate for thin film formation as described in Item 141, 142, 147, or 148, wherein the transition metal ingredient is at least one or more ingredients selected from iron and chromium.

Item 150. The substrate for thin film formation as described in Item 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, or 149, wherein the sintered compact which comprises a zinc oxide as the main ingredients contains an aluminum ingredient and contains simultaneously at least one or more ingredients selected from a rare earth element ingredient and a transition metal ingredient.

Item 151. The substrate for thin film formation as described in Item 150, wherein the sintered compact which comprises a zinc oxide as the main ingredients contains an aluminum ingredient and contains simultaneously at least one or more ingredients selected from a rare earth element ingredient.

Item 152. The substrate for thin film formation as described in Item 150, wherein the sintered compact which comprises a zinc oxide as the main ingredients contains an aluminum ingredient and contains simultaneously at least one or more ingredients selected from a transition metal ingredient.

Item 153. The substrate for thin film formation as described in Item 150 or 152, wherein the transition metal ingredient is at least one or more ingredients selected from iron and chromium.

Item 154. The substrate for thin film formation as described in Item 150, 151, 152, or 153, wherein the sintered compact which comprises a zinc oxide as the main ingredients contains at least one or more ingredients selected from a rare earth element ingredient and a transition metal ingredient not more than 10.0 mol % by oxide conversion.

Item 155. The substrate for thin film formation as described in Item 154, wherein the sintered compact which comprises a zinc oxide as the main ingredients contains at least one or more ingredients selected from a rare earth element ingredient not more than 10.0 mol % by oxide conversion.

Item 156. The substrate for thin film formation as described in Item 154 or 155, wherein the sintered compact which comprises a zinc oxide as the main ingredients contains at least one or more ingredients selected from a transition metal ingredient not more than 10.0 mol % by oxide conversion.

Item 157. The substrate for thin film formation as described in Item 150, 151, 152, 153, 154, 155, or 156, wherein the sintered compact which comprises a zinc oxide as the main ingredients contains an aluminum ingredient not more than 45.0 mol % by Al₂O₃ conversion and contains simultaneously at least one or more ingredients selected from a rare earth element ingredient not more than 10.0 mol % by oxide conversion.

Item 158. The substrate for thin film formation as described in Item 157, wherein the sintered compact which comprises a zinc oxide as the main ingredients contains an aluminum ingredient not more than 45.0 mol % by Al₂O₃ conversion and contains simultaneously at least one or more ingredients selected from a rare earth element ingredient in the range of 0.0002 mol %-10.0 mol % by oxide conversion.

Item 159. The substrate for thin film formation as described in Item 157 or 158, wherein the sintered compact which comprises a zinc oxide as the main ingredients contains an aluminum ingredient not more than 45.0 mol % by Al₂O₃ conversion and contains simultaneously at least one or more ingredients selected from a rare earth element ingredient in the range of 0.0006 mol %-6.0 mol % by oxide conversion.

Item 160. The substrate for thin film formation as described in Item 157, 158, or 159, wherein the sintered compact which comprises a zinc oxide as the main ingredients contains an aluminum ingredient not more than 45.0 mol % by Al₂O₃ conversion and contains simultaneously at least one or more ingredients selected from a rare earth element ingredient in the range of 0.001 mol %-6.0 mol % by oxide conversion.

Item 161. The substrate for thin film formation as described in Item 157, 158, 159, or 160, wherein the sintered compact which comprises a zinc oxide as the main ingredients contains an aluminum ingredient not more than 45.0 mol % by Al₂O₃ conversion and contains simultaneously at least one or more ingredients selected from a rare earth element ingredient in the range of 0.002 mol %-3.0 mol % by oxide conversion.

Item 162. The substrate for thin film formation as described in Item 150, 151, 152, 153, 154, 155, 156, 157, 158, 159, 160, or 161, wherein the sintered compact which comprises a zinc oxide as the main ingredients contains an aluminum ingredient in the range of 0.001 mol %-45.0 mol % by Al₂O₃ conversion and contains simultaneously at least one or more ingredients selected from a rare earth element ingredient.

Item 163. The substrate for thin film formation as described in Item 114 or 115, wherein the ceramic material which has at least one of the crystal structures selected from a hexagonal system or a trigonal system consists of a sintered compact which comprises a beryllium oxide as the main ingredients.

Item 164. The substrate for thin film formation as described in Item 115 or 163, wherein the sintered compact which comprises a beryllium oxide as the main ingredients has optical permeability.

Item 165. The substrate for thin film formation as described in Item 115, 163, or 164, wherein the sintered compact which comprises a beryllium oxide as the main ingredients has the optical transmissivity not less than 1%.

Item 166. The substrate for thin film formation as described in Item 165, wherein the sintered compact which comprises a beryllium oxide as the main ingredients has the optical transmissivity not less than 10%.

Item 167. The substrate for thin film formation as described in Item 165 or 166, wherein the sintered compact which comprises a beryllium oxide as the main ingredients has the optical transmissivity not less than 20%.

Item 168. The substrate for thin film formation as described in Item 165, 166, or 167, wherein the sintered compact which comprises a beryllium oxide as the main ingredients has the optical transmissivity not less than 30%.

Item 169. The substrate for thin film formation as described in Item 165, 166, 167, or 168, wherein the sintered compact which comprises a beryllium oxide as the main ingredients has the optical transmissivity not less than 40%.

Item 170. The substrate for thin film formation as described in Item 165, 166, 167, 168, or 169, wherein the sintered compact which comprises a beryllium oxide as the main ingredients has the optical transmissivity not less than 50%.

Item 171. The substrate for thin film formation as described in Item 165, 166, 167, 168, 169, or 170, wherein the sintered compact which comprises a beryllium oxide as the main ingredients has the optical transmissivity not less than 60%.

Item 172. The substrate for thin film formation as described in Item 165, 166, 167, 168, 169, 170, or 171, wherein the sintered compact which comprises a beryllium oxide as the main ingredients has the optical transmissivity not less than 80%.

Item 173. The substrate for thin film formation as described in Item 114, 115, or 163, wherein the optical transmissivity of the sintered compact which comprises a beryllium oxide as the main ingredients is smaller than 1%.

Item 174. The substrate for thin film formation as described in Item 173, wherein the optical transmissivity of the sintered compact which comprises a beryllium oxide as the main ingredients is 0%.

Item 175. The substrate for thin film formation as described in Item 164, 165, 166, 167, 168, 169, 170, 171, 172, 173, or 174, wherein the optical permeability or optical transmissivity is a thing in the light of the range of 200 nm-800 nm wavelength at least.

Item 176. The substrate for thin film formation as described in Item 115, 163, 164, 165, 166, 167, 168, 169, 170, 171, 172, 173, 174, or 175, wherein the sintered compact which comprises a beryllium oxide as the main ingredients contains at least one or more ingredients selected from a magnesium ingredient, a calcium ingredient, and a silicon ingredient.

Item 177. The substrate for thin film formation as described in Item 115, 163, 164, 165, 166, 167, 168, 169, 170, 171, 172, 173, 174, 175, or 176, wherein the sintered compact which comprises a beryllium oxide as the main ingredients contains a beryllium oxide ingredient not less than 65.0 mol % by BeO conversion.

Item 178. The substrate for thin film formation as described in Item 115, 163, 164, 165, 166, 167, 168, 169, 170, 171, 172, 173, 174, 174, 176, or 177, wherein the sintered compact which comprises a beryllium oxide as the main ingredients contains at least one or more ingredients selected from a magnesium ingredient, a calcium ingredient, and a silicon ingredient a total of not more than 35.0 mol % by oxide conversion.

Item 179. The substrate for thin film formation as described in Item 178, wherein the sintered compact which comprises a beryllium oxide as the main ingredients contains at least one or more ingredients selected from a magnesium ingredient, a calcium ingredient, and a silicon ingredient in the range of 0.0002 mol %-35.0 mol % in total by oxide conversion.

Item 180. The substrate for thin film formation as described in Item 178 or 179, wherein the sintered compact which comprises a beryllium oxide as the main ingredients contains at least one or more ingredients selected from a magnesium ingredient, a calcium ingredient, and a silicon ingredient in the range of 0.001 mol %-35.0 mol % in total by oxide conversion.

Item 181. The substrate for thin film formation as described in Item 178, 179, or 180, wherein the sintered compact which comprises a beryllium oxide as the main ingredients contains at least one or more ingredients selected from a magnesium ingredient, a calcium ingredient, and a silicon ingredient in the range of 0.004 mol %-35.0 mol % in total by oxide conversion.

Item 182. The substrate for thin film formation as described in Item 176, 177, 178, 179, 180, or 181, wherein the sintered compact which comprises a beryllium oxide as the main ingredients contains at least one or more ingredients selected from a magnesium ingredient, a calcium ingredient, and a silicon ingredient in the range of 0.015 mol %-25.0 mol % in total by oxide conversion.

Item 183. The substrate for thin film formation as described in Item 115, 163, 164, 165, 166, 167, 168, 169, 170, 171, 172, 173, 174, 175, 176, 177, 178, 179, 180, 181, or 182, wherein the sintered compact which comprises a beryllium oxide as the main ingredients contains at least one or more ingredients selected from a magnesium ingredient, a calcium ingredient, and a silicon ingredient and contains simultaneously at least one or more ingredients selected from a rare earth element ingredient.

Item 184. The substrate for thin film formation as described in Item 183, wherein the sintered compact which comprises a beryllium oxide as the main ingredients contains at least one or more ingredients selected from a magnesium ingredient, a calcium ingredient, and a silicon ingredient and contains simultaneously at least one or more ingredients selected from a rare earth element ingredient not more than 5.0 mol % by oxide conversion.

Item 185. The substrate for thin film formation as described in Item 183 or 184, wherein the sintered compact which comprises a beryllium oxide as the main ingredients contains at least one or more ingredients selected from a magnesium ingredient, a calcium ingredient, and a silicon ingredient not more than 35.0 mol % by oxide conversion and contains simultaneously at least one or more ingredients selected from a rare earth element ingredient not more than 5.0 mol % by oxide conversion.

Item 186. The substrate for thin film formation as described in Item 183, 184, or 185, wherein the sintered compact which comprises a beryllium oxide as the main ingredients contains at least one or more ingredients selected from a magnesium ingredient, a calcium ingredient, and a silicon ingredient not more than 35.0 mol % by oxide conversion and contains simultaneously at least one or more ingredients selected from a rare earth element ingredient in the range of 0.00005 mol %-5.0 mol % by oxide conversion.

Item 187. The substrate for thin film formation as described in Item 183, 184, 185, or 186, wherein the sintered compact which comprises a beryllium oxide as the main ingredients contains at least one or more ingredients selected from a magnesium ingredient, a calcium ingredient, and a silicon ingredient not more than 35.0 mol % by oxide conversion and contains simultaneously at least one or more ingredients selected from a rare earth element ingredient in the range of 0.0005 mol %-3.0 mol % by oxide conversion.

Item 188. The substrate for thin film formation as described in Item 183, 184, 185, 186, or 187, wherein the sintered compact which comprises a beryllium oxide as the main ingredients contains at least one or more ingredients selected from a magnesium ingredient, a calcium ingredient, and a silicon ingredient not more than 35.0 mol % by oxide conversion and contains simultaneously at least one or more ingredients selected from a rare earth element ingredient in the range of 0.002 mol %-3.0 mol % by oxide conversion.

Item 189. The substrate for thin film formation as described in Item 183, 184, 185, 186, 187, or 188, wherein the sintered compact which comprises a beryllium oxide as the main ingredients contains at least one or more ingredients selected from a magnesium ingredient, a calcium ingredient, and a silicon ingredient not more than 35.0 mol % by oxide conversion and contains simultaneously at least one or more ingredients selected from a rare earth element ingredient in the range of 0.005 mol %-3.0 mol % by oxide conversion.

Item 190. The substrate for thin film formation as described in Item 183, 184, 185, 186, 187, 188, or 189, wherein the sintered compact which comprises a beryllium oxide as the main ingredients contains at least one or more ingredients selected from a magnesium ingredient, a calcium ingredient, and a silicon ingredient in the range of 0.0002 mol %-35.0 mol % by oxide conversion and contains simultaneously at least one or more ingredients selected from a rare earth element ingredient.

Item 191. The substrate for thin film formation as described in Item 114 or 115, wherein the ceramic material which has at least one of the crystal structures selected from a hexagonal system or a trigonal system consists of a sintered compact which comprises an aluminum oxide as the main ingredients.

Item 192. The substrate for thin film formation as described in Item 115 or 191, wherein the sintered compact which comprises an aluminum oxide as the main ingredients has optical permeability.

Item 193. The substrate for thin film formation as described in Item 115, 191, or 192, wherein the sintered compact which comprises an aluminum oxide as the main ingredients has the optical transmissivity not less than 1%.

Item 194. The substrate for thin film formation as described in Item 193, wherein the sintered compact which comprises an aluminum oxide as the main ingredients has the optical transmissivity not less than 10%.

Item 195. The substrate for thin film formation as described in Item 193 or 194, wherein the sintered compact which comprises an aluminum oxide as the main ingredients has the optical transmissivity not less than 20%.

Item 196. The substrate for thin film formation as described in Item 193, 194, or 195, wherein the sintered compact which comprises an aluminum oxide as the main ingredients has the optical transmissivity not less than 30%.

Item 197. The substrate for thin film formation as described in Item 193, 194, 195, or 196, wherein the sintered compact which comprises an aluminum oxide as the main ingredients has the optical transmissivity not less than 40%.

Item 198. The substrate for thin film formation as described in Item 193, 194, 195, 196, or 197, wherein the sintered compact which comprises an aluminum oxide as the main ingredients has the optical transmissivity not less than 50%.

Item 199. The substrate for thin film formation as described in Item 193, 194, 195, 196, 197, or 198, wherein the sintered compact which comprises an aluminum oxide as the main ingredients has the optical transmissivity not less than 60%.

Item 200. The substrate for thin film formation as described in Item 193, 194, 195, 196, 197, 198, or 199, wherein the sintered compact which comprises an aluminum oxide as the main ingredients has the optical transmissivity not less than 80%.

Item 201. The substrate for thin film formation as described in Item 114, 115, or 191, wherein the optical transmissivity of the sintered compact which comprises an aluminum oxide as the main ingredients is smaller than 1%.

Item 202. The substrate for thin film formation as described in Item 201, wherein the optical transmissivity of the sintered compact which comprises an aluminum oxide as the main ingredients is 0%.

Item 203. The substrate for thin film formation as described in Item 192, 193, 194, 195, 196, 197, 198, 199, 200, 201, or 202, wherein the optical permeability or optical transmissivity is a thing in the light of the range of 200 nm-800 nm wavelength at least.

Item 204. The substrate for thin film formation as described in Item 191, 192, 193, 194, 195, 196, 197, 198, 199, 200, 201, 202, or 203, wherein the sintered compact which comprises an aluminum oxide as the main ingredients contains at least one or more ingredients selected from a magnesium ingredient, a calcium ingredient, and a silicon ingredient.

Item 205. The substrate for thin film formation as described in Item 115, 191, 192, 193, 194, 195, 196, 197, 198, 199, 200, 201, 202, 203, or 204, wherein the sintered compact which comprises an aluminum oxide as the main ingredients contains an aluminum oxide ingredient not less than 55.0 mol % by Al₂O₃ conversion.

Item 206. The substrate for thin film formation as described in Item 115, 191, 192, 193, 194, 195, 196, 197, 198, 199, 200, 201, 202, 203, 204, or 205, wherein the sintered compact which comprises an aluminum oxide as the main ingredients contains at least one or more ingredients selected from a magnesium ingredient, a calcium ingredient, and a silicon ingredient a total of not more than 45.0 mol % by oxide conversion.

Item 207. The substrate for thin film formation as described in Item 206, wherein the sintered compact which comprises an aluminum oxide as the main ingredients contains at least one or more ingredients selected from a magnesium ingredient, a calcium ingredient, and a silicon ingredient in the range of 0.001 mol %-45.0 mol % in total by oxide conversion.

Item 208. The substrate for thin film formation as described in Item 206 or 207, wherein the sintered compact which comprises an aluminum oxide as the main ingredients contains at least one or more ingredients selected from a magnesium ingredient, a calcium ingredient, and a silicon ingredient in the range of 0.005 mol %-45.0 mol % in total by oxide conversion.

Item 209. The substrate for thin film formation as described in Item 206, 207, or 208, wherein the sintered compact which comprises an aluminum oxide as the main ingredients contains at least one or more ingredients selected from a magnesium ingredient, a calcium ingredient, and a silicon ingredient in the range of 0.02 mol %-45.0 mol % in total by oxide conversion.

Item 210. The substrate for thin film formation as described in Item 206, 207, 208, or 209, wherein the sintered compact which comprises an aluminum oxide as the main ingredients contains at least one or more ingredients selected from a magnesium ingredient, a calcium ingredient, and a silicon ingredient in the range of 0.08 mol %-35.0 mol % in total by oxide conversion.

Item 211. The substrate for thin film formation as described in Item 115, 191, 192, 193, 194, 195, 196, 197, 198, 199, 200, 201, 202, 203, 204, 205, 206, 207, 208, 209, or 210, wherein the sintered compact which comprises an aluminum oxide as the main ingredients contains at least one or more ingredients selected from a magnesium ingredient, a calcium ingredient, and a silicon ingredient and contains simultaneously at least one or more ingredients selected from a rare earth element ingredient.

Item 212. The substrate for thin film formation as described in Item 211, wherein the sintered compact which comprises an aluminum oxide as the main ingredients contains at least one or more ingredients selected from a magnesium ingredient, a calcium ingredient, and a silicon ingredient and contains simultaneously at least one or more ingredients selected from a rare earth element ingredient not more than 10.0 mol % by oxide conversion.

Item 213. The substrate for thin film formation as described in Item 211 or 212, wherein the sintered compact which comprises an aluminum oxide as the main ingredients contains at least one or more ingredients selected from a magnesium ingredient, a calcium ingredient, and a silicon ingredient not more than 45.0 mol % by oxide conversion and contains simultaneously at least one or more ingredients selected from a rare earth element ingredient not more than 10.0 mol % by oxide conversion.

Item 214. The substrate for thin film formation as described in Item 211, 212, or 213, wherein the sintered compact which comprises an aluminum oxide as the main ingredients contains at least one or more ingredients selected from a magnesium ingredient, a calcium ingredient, and a silicon ingredient not more than 45.0 mol % by oxide conversion and contains simultaneously at least one or more ingredients selected from a rare earth element ingredient in the range of 0.0002 mol %-10.0 mol % by oxide conversion.

Item 215. The substrate for thin film formation as described in Item 211, 212, 213, or 214, wherein the sintered compact which comprises an aluminum oxide as the main ingredients contains at least one or more ingredients selected from a magnesium ingredient, a calcium ingredient, and a silicon ingredient not more than 45.0 mol % by oxide conversion and contains simultaneously at least one or more ingredients selected from a rare earth element ingredient in the range of 0.001 mol %-6.0 mol % by oxide conversion.

Item 216. The substrate for thin film formation as described in Item 211, 212, 213, 214, or 215, wherein the sintered compact which comprises an aluminum oxide as the main ingredients contains at least one or more ingredients selected from a magnesium ingredient, a calcium ingredient, and a silicon ingredient not more than 45.0 mol % by oxide conversion and contains simultaneously at least one or more ingredients selected from a rare earth element ingredient in the range of 0.005 mol %-6.0 mol % by oxide conversion.

Item 217. The substrate for thin film formation as described in Item 211, 212, 213, 214, 215, or 216, wherein the sintered compact which comprises an aluminum oxide as the main ingredients contains at least one or more ingredients selected from a magnesium ingredient, a calcium ingredient, and a silicon ingredient not more than 45.0 mol % by oxide conversion and contains simultaneously at least one or more ingredients selected from a rare earth element ingredient in the range of 0.01 mol %-6.0 mol % by oxide conversion.

Item 218. The substrate for thin film formation as described in Item 211, 212, 213, 214, 215, 216, or 217, wherein the sintered compact which comprises an aluminum oxide as the main ingredients contains at least one or more ingredients selected from a magnesium ingredient, a calcium ingredient, and a silicon ingredient in the range of 0.001 mol %-45.0 mol % by oxide conversion and contains simultaneously at least one or more ingredients selected from a rare earth element ingredient.

Item 219. The substrate for thin film formation as described in Item 115, 191, 192, 193, 194, 195, 196, 197, 198, 199,200, 201, 202, 203, 204, 205, 206, 207, 208, 209, 210, 211, 212, 213, 214, 215, 216, 217, or 218, wherein the sintered compact which comprises an aluminum oxide as the main ingredients contains at least two or more ingredients selected from a magnesium ingredient, a calcium ingredient, and a silicon ingredient.

Item 220. The substrate for thin film formation which consists of a sintered compact comprising a ceramic material having at least one of the crystal structures selected from a hexagonal system or a trigonal system as the main ingredients and was described in Item 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, or 219, and the surface of the substrate is a smooth nature not more than 1000 nm as average surface roughness Ra.

Item 221. The substrate for thin film formation as described in Item 220, wherein the substrate surface is a smooth nature not more than 100 nm as average surface roughness Ra.

Item 222. The substrate for thin film formation as described in Item 220 or 221, wherein the substrate surface is a smooth nature not more than 10 nm as average surface roughness Ra.

Item 223. The substrate for thin film formation as described in Item 220, 221, or 222, wherein the substrate surface is a smooth nature not more than 5 nm as average surface roughness Ra.

Item 224. The substrate for thin film formation which consists of a sintered compact comprising a ceramic material having at least one of the crystal structures selected from a hexagonal system or a trigonal system as the main ingredients and was described in Item 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, or 219, and the surface of the substrate has a smooth nature more than 1000 nm as average surface roughness Ra.

Item 225. The substrate for thin film formation as described in Item 220, 221, 222, 223, or 224, wherein the substrate surface is in at least one of the states selected from as-fired one (as-fire), lap polish or specular surface polish.

Item 226. The substrate for thin film formation as described in Item 220, 221, 222, 223, 224, or 225, wherein the substrate surface is a state in which specular surface polish was performed.

Item 227. A substrate for thin film formation in which a thin film comprises at least one or more materials selected from a gallium nitride, an indium nitride, and an aluminum nitride as the main ingredients, and the substrate consists of a sintered compact which comprises a ceramic material as the main ingredients and which has optical permeability.

Item 228. The substrate for thin film formation as described in Item 227, wherein the ceramic material is at least one or more materials selected from a zirconium dioxide, a magnesium oxide, a magnesium aluminate, a titanium oxide, a barium titanate, a lead titanate zirconate, rare earth element oxides, a thorium dioxide, various ferrites, a mullite, a forsterite, a steatite, and glass ceramics.

Item 229. The substrate for thin film formation as described in Item 227 or 228, wherein the ceramic material is at least one or more materials selected from a zirconium dioxide, a magnesium oxide, a magnesium aluminate, rare earth element oxides, a thorium dioxide, a mullite, and glass ceramics.

Item 230. The substrate for thin film formation as described in Item 227, 228, or 229, wherein the ceramic material is at least one or more materials selected from a zirconium dioxide, a magnesium oxide, a magnesium aluminate, a yttrium oxide.

Item 231. The substrate for thin film formation as described in Item 227, 228, 229, or 230, wherein the sintered compact which comprises a ceramic material as the main ingredients has the optical transmissivity not less than 1%.

Item 232. The substrate for thin film formation as described in Item 231, wherein the sintered compact which comprises a ceramic material as the main ingredients has the optical transmissivity not less than 10%.

Item 233. The substrate for thin film formation as described in Item 231 or 232, wherein the sintered compact which comprises a ceramic material as the main ingredients has the optical transmissivity not less than 20%.

Item 234. The substrate for thin film formation as described in Item 231, 232, or 233, wherein the sintered compact which comprises a ceramic material as the main ingredients has the optical transmissivity not less than 30%.

Item 235. The substrate for thin film formation as described in Item 231, 232, 233, or 234, wherein the sintered compact which comprises a ceramic material as the main ingredients has the optical transmissivity not less than 40%.

Item 236. The substrate for thin film formation as described in Item 231, 232, 233, 234, or 235, wherein the sintered compact which comprises a ceramic material as the main ingredients has the optical transmissivity not less than 50%.

Item 237. The substrate for thin film formation as described in Item 231, 232, 233, 234, 235, or 236, wherein the sintered compact which comprises a ceramic material as the main ingredients has the optical transmissivity not less than 60%.

Item 238. The substrate for thin film formation as described in Item 231, 232, 233, 234, 235, 236, or 237, wherein the sintered compact which comprises a ceramic material as the main ingredients has the optical transmissivity not less than 80%.

Item 239. The substrate for thin film formation as described in Item 227, 228, 229, or 230, wherein the optical transmissivity of the sintered compact which comprises as the main ingredients a ceramic material is smaller than I %.

Item 240. The substrate for thin film formation as described in Item 239, wherein the sintered compact which comprises a ceramic material as the main ingredients has the optical transmissivity of0%.

Item 241. The substrate for thin film formation as described in Item 227, 228, 229, 230, 231, 232, 233, 234, 235, 236, 237, 238, 239, or 240, wherein the optical permeability or optical transmissivity is a thing in the light of the range of 200 nm-800 nm wavelength at least.

Item 242. The substrate for thin film formation in which a thin film comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, or 241, and the thin film which is formed on the substrate and comprises as the main ingredients at least one or more materials selected from a gallium nitride, an indium nitride, and an aluminum nitride is at least one of the crystallized states selected from a single crystal, an amorphous state, a polycrystal, and an orientated polycrystal.

Item 243. The substrate for thin film formation as described in Item 242, wherein at least a part of the thin film which is formed on the substrate and comprises as the main ingredients at least one or more materials selected from a gallium nitride, an indium nitride, and an aluminum nitride is a single crystal.

Item 244. The substrate for thin film formation as described in Item 242, or 243, wherein at least a part of the thin film which is formed on the substrate and comprises as the main ingredients at least one or more materials selected from a gallium nitride, an indium nitride, and an aluminum nitride is a single crystal and further consists of at least one of the crystallized states selected from an amorphous state, a polycrystal, and an orientated polycrystal.

Item 245. The substrate for thin film formation as described in Item 243, wherein the thin film which is formed on the substrate and comprises as the main ingredients at least one or more materials selected from a gallium nitride, an indium nitride, and an aluminum nitride is a single crystal altogether.

Item 246. The substrate for thin film formation as described in Item 242, 243, or 244, wherein at least a part of the thin film which is formed on the substrate and comprises as the main ingredients at least one or more materials selected from a gallium nitride, an indium nitride, and an aluminum nitride is amorphous.

Item 247. The substrate for thin film formation as described in Item 246, wherein at least a part of the thin film which is formed on the substrate and comprises as the main ingredients at least one or more materials selected from a gallium nitride, an indium nitride, and an aluminum nitride is amorphous and further consists of at least one of the crystallized states selected from a single crystal, a polycrystal, and an orientated polycrystal.

Item 248. The substrate for thin film formation as described in Item 246, wherein the thin film which is formed on the substrate and comprises as the main ingredients at least one or more materials selected from a gallium nitride, an indium nitride, and an aluminum nitride is amorphous altogether.

Item 249. The substrate for thin film formation as described in Item 242, 243, 244, 246, or 247, wherein at least a part of the thin film which is formed on the substrate and comprises as the main ingredients at least one or more materials selected from a gallium nitride, an indium nitride, and an aluminum nitride is a polycrystal.

Item 250. The substrate for thin film formation as described in Item 249, wherein at least a part of the thin film which is formed on the substrate and comprises as the main ingredients at least one or more materials selected from a gallium nitride, an indium nitride, and an aluminum nitride is a polycrystal and further consists of at least one of the crystallized states selected from a single crystal, an amorphous state, and an orientated polycrystal.

Item 251. The substrate for thin film formation as described in Item 249, wherein the thin film which is formed on the substrate and comprises as the main ingredients at least one or more materials selected from a gallium nitride, an indium nitride, and an aluminum nitride is a polycrystal altogether.

Item 252. The substrate for thin film formation as described in Item 242, 243, 244, 246, 247, 249, or 250, wherein at least a part of the thin film which is formed on the substrate and comprises as the main ingredients at least one or more materials selected from a gallium nitride, an indium nitride, and an aluminum nitride is an orientated polycrystal.

Item 253. The substrate for thin film formation as described in Item 252, wherein at least a part of the thin film which is formed on the substrate and comprises as the main ingredients at least one or more materials selected from a gallium nitride, an indium nitride, and an aluminum nitride is an orientated polycrystal and further consists of at least one of the crystallized states selected from a single crystal, an amorphous state, and a polycrystal.

Item 254. The substrate for thin film formation as described in Item 252, wherein the thin film which is formed on the substrate and comprises as the main ingredients at least one or more materials selected from a gallium nitride, an indium nitride, and an aluminum nitride is an orientated polycrystal altogether.

Item 255. The substrate for thin film formation as described in Item 242, 243, 244, 245, 246, 247, 249, 250, 252, or 253, wherein at least a part of the thin film which is formed on the substrate and comprises as the main ingredients at least one or more materials selected from a gallium nitride, an indium nitride, and an aluminum nitride is a single crystal, and the single crystal portion of this thin film is directly formed on the substrate which consists of a sintered compact which comprises an aluminum nitride as the main ingredients.

Item 256. The substrate for thin film formation as described in Item 242, 243, 244, 245, 246, 247, 249, 250, 252, or 253, wherein at least a part of the thin film which is formed on the substrate and comprises as the main ingredients at least one or more materials selected from a gallium nitride, an indium nitride, and an aluminum nitride is a single crystal, and the single crystal portion of this thin film is directly formed on the substrate which consists of a sintered compact which comprises as the main ingredients a ceramic material which has at least one of the crystal structures selected from a hexagonal system or a trigonal system.

Item 257. The substrate for thin film formation as described in Item 242, 243, 244, 246, 247, 248, 249, 250, 251, 252, 253, or 254, wherein at least a part of the thin film which is formed on the substrate and comprises as the main ingredients at least one or more materials selected from a gallium nitride, an indium nitride, and an aluminum nitride is at least one of the crystallized states selected from an amorphous state, a polycrystal, and an orientated polycrystal, a portion of this thin film of at least one of the crystallized states selected from an amorphous state, a polycrystal, and an orientated polycrystal is directly formed on the substrate which consists of a sintered compact which comprises an aluminum nitride as the main ingredients.

Item 258. The substrate for thin film formation as described in Item 242, 243, 244, 246, 247, 248, 249, 250, 251, 252, 253, or 254, wherein at least a part of the thin film which is formed on the substrate and comprises as the main ingredients at least one or more materials selected from a gallium nitride, an indium nitride, and an aluminum nitride is at least one of the crystallized states selected from an amorphous state, a polycrystal, and an orientated polycrystal, a portion of this thin film of at least one of the crystallized states selected from an amorphous state, a polycrystal, and an orientated polycrystal is directly formed on the substrate which consists of a sintered compact which comprises as the main ingredients a ceramic material which has at least one of the crystal structures selected from a hexagonal system or a trigonal system.

Item 259. The substrate for thin film formation as described in Item 242, 243, 244, 246, 247, 248, 249, 250, 251, 252, 253, or 254, wherein at least a part of the thin film which is formed on the substrate and comprises as the main ingredients at least one or more materials selected from a gallium nitride, an indium nitride, and an aluminum nitride is at least one of the crystallized states selected from an amorphous state, a polycrystal, and an orientated polycrystal, a portion of this thin film of at least one of the crystallized states selected from an amorphous state, a polycrystal, and an orientated polycrystal is directly formed on the substrate which consists of a sintered compact which comprises a ceramic material as the main ingredients and which has optical permeability.

Item 260. The substrate for thin film formation as described in Item 242, 243, 244, 245, 246, 247, 248, 249, 250, 251, 252, 253, 254, 255, 256, 257, 258, or 259, wherein the thin film which is formed on the substrate and comprises as the main ingredients at least one or more materials selected from a gallium nitride, an indium nitride, and an aluminum nitride is constituted with at least two or more layers.

Item 261. The substrate for thin film formation as described in Item 260, wherein each layer of thin films which are constituted with two or more layers is at least one of the crystallized states selected from a single crystal, an amorphous state, a polycrystal, and an orientated polycrystal.

Item 262. The substrate for thin film formation as described in Item 260 or 261, wherein in the thin film which is constituted with two or more layers, the thin film directly formed on the substrate is at least one of the crystallized states selected from a single crystal, an amorphous state, a polycrystal, and an orientated polycrystal.

Item 263. The substrate for thin film formation as described in Item 260, 261, or 262, wherein in the thin film which is constituted with two or more layers, the thin film directly formed on the substrate is at least one of the crystallized states selected from an amorphous state, a polycrystal, and an orientated polycrystal.

Item 264. The substrate for thin film formation as described in Item 260, 261, 262, or 263, wherein in the thin film which is constituted with two or more layers, the thin film directly formed on the substrate is at least one of the crystallized states selected from an amorphous state, a polycrystal, and an orientated polycrystal, and the thin film formed on it is a single crystal.

Item 265. The substrate for thin film formation as described in Item 264, wherein in the thin film which is constituted with two or more layers, the thin film directly formed on the substrate is amorphous, and the thin film formed on it is a single crystal.

Item 266. The substrate for thin film formation as described in Item 264, wherein in the thin film which is constituted with two or more layers, the thin film directly formed on the substrate is a polycrystal, and the thin film formed on it is a single crystal.

Item 267. The substrate for thin film formation as described in Item 264, wherein in the thin film which is constituted with two or more layers, the thin film directly formed on the substrate is an orientated polycrystal, and the thin film formed on it is a single crystal.

Item 268. The substrate for thin film formation as described in Item 260, 261, 262, 263, 264, 265, 266, or 267, wherein in the thin film which is constituted with two or more layers, the thin film directly formed on the substrate is at least one of the crystallized states selected from an amorphous state, a polycrystal, and an orientated polycrystal, and the thin film formed on it is a single crystal.

Item 269. The substrate for thin film formation as described in Item 260, 261, 262, 263, 264, 265, 266, 267, or 268, wherein in the thin film which is constituted with two or more layers, at least two or more layers consist of a single crystal.

Item 270. The substrate for thin film formation as described in Item 260, 261, 262, or 269, wherein in the thin film which is constituted with two or more layers, the thin film directly formed on the substrate consists of a single crystal.

Item 271. The substrate for thin film formation as described in Item 260, 261, 262, 269, or 270, wherein in the thin film which is constituted with two or more layers, all layers consist of a single crystal.

Item 272. The substrate for thin film formation as described in Item 260, 261, 262, 263, 264, 265, 266, 267, 268, 269, 270, or 271, wherein at least two layers consist of different composition among the thin film which is constituted with two or more layers.

Item 273. The substrate for thin film formation as described in Item 242, 243, 244, 245, 246, 247, 249, 250, 252, 253, 255, 256, 257,258, 259, 260, 261, 262, 263, 264, 265, 266, 267, 268, 269, 270, 271, or 272, wherein at least a part of thin films formed on a substrate consists of a single crystal and the crystal C axis of this single crystal thin film is formed in the perpendicular direction to a substrate surface.

Item 274. The substrate for thin film formation as described in Item 273, wherein all thin films formed on a substrate consist of a single crystal and the crystal C axis of this single crystal thin film is formed in the perpendicular direction to a substrate surface.

Item 275. The substrate for thin film formation as described in Item 242, 243, 244, 245, 246, 247, 249, 250, 252, 253, 255, 256, 257, 258, 259, 260, 261, 262, 263, 264, 265, 266, 267, 268, 269, 270, 271, or 272, wherein at least a part of the thin films formed on a substrate consists of a single crystal and the crystal C axis of this single crystal thin film is formed in the level direction to a substrate surface.

Item 276. The substrate for thin film formation as described in Item 275, wherein all thin films formed on a substrate consist of a single crystal and the crystal C axis of this single crystal thin film is formed in the level direction to a substrate surface.

Item 277. The substrate for thin film formation in which a thin film comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, or 276, and the thin film formed on a substrate has electrical conductivity.

Item 278. The substrate for thin film formation as described in Item 277, wherein the thin film has conductivity by being semiconductor-ized.

Item 279. The substrate for thin film formation as described in Item 277 or 278, wherein the thin film is semiconductor-ized by at least one or more doping ingredients selected from magnesium, beryllium, calcium, zinc, cadmium, carbon, silicon, germanium, selenium, tellurium, and oxygen and has conductivity.

Item 280. The substrate for thin film formation as described in Item 277, 278, or 279, wherein the thin film is semiconductor-ized into P type by at least one or more doping ingredients selected from magnesium, beryllium, calcium, zinc, cadmium, and carbon and has conductivity.

Item 281. The substrate for thin film formation as described in Item 277, 278, or 279, wherein the thin film is semiconductor-ized into N type by at least one or more doping ingredients selected from silicon, germanium, selenium, tellurium, and oxygen and has conductivity.

Item 282. The substrate for thin film formation as described in Item 277, 278, 279, 280, or 281, wherein the thin film contains a doping ingredient in the range of 0.00001-10 mol % to the main ingredients.

Item 283. The substrate for thin film formation as described in Item 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, or 282, wherein the thin film is constituted with at least two or more layers, and at least one layer in this thin film has conductivity.

Item 284. The substrate for thin film formation as described in Item 277, 278, 279, 280, 281, 282, or 283, wherein the electric resistivity of the thin film which has conductivity is not more than 1×10⁴ Ω·cm in room temperature.

Item 285. The substrate for thin film formation as described in Item 284, wherein the electric resistivity of the thin film which has conductivity is not more than 1×10² Ω·cm in room temperature.

Item 286. The substrate for thin film formation as described in Item 284 or 285, wherein the electric resistivity of the thin film which has conductivity is not more than 1×10¹ Ω·cm in room temperature.

Item 287. The substrate for thin film formation as described in Item 284, 285, or 286, wherein the electric resistivity of the thin film which has conductivity is not more than 1×10⁰ Ω·cm in room temperature.

Item 288. The substrate for thin film formation in which a thin film comprises at least one or more materials selected from a gallium nitride, an indium nitride, and an aluminum nitride as the main ingredients and was described in Item 1, 2, 3,4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, or 287, and the thin film formed on a substrate comprises as the main ingredients a composite expressed with the chemical formula of AlₓGa₁₋ₓN (0≦x≦1.0).

Item 289. The substrate for thin film formation as described in Item 288, wherein the thin film comprises as the main ingredients a composite expressed with the chemical formula of AlₓGa₁₋ₓN (0≦x≦1.0) and is what contains at least one or more ingredients selected from Mg (magnesium), Be (beryllium), and Zn (zinc) in the range of 0.00001-10 mol % to this composite.

Item 290. The substrate for thin film formation as described in Item 288 or 289, wherein the thin film comprises as the main ingredients a composite expressed with the chemical formula of AlₓGa₁₋ₓN (0≦x≦1.0) and is what contains Si (silicon) in the range of 0.00001-10 mol % to this composite.

Item 291. The substrate for thin film formation as described in Item 288, 289, or 290, wherein the thin film comprises as the main ingredients a composite expressed with the chemical formula of AlₓGa₁₋ₓN (0≦x≦1.0) and is what contains simultaneously at least one or more ingredients selected from Mg, Be, and Zn and Si in the range of 0.00001-10 mol % in total to this composite.

Item 292. The substrate for thin film formation as described in Item 288, 289, 290, or 291, wherein the thin film comprises as the main ingredients a composite expressed with the chemical formula of AlₓGa₁₋ₓN (0≦x≦0.6).

Item 293. The substrate for thin film formation as described in Item 292, wherein the thin film comprises as the main ingredients a composite expressed with the chemical formula of AlₓGa₁₋ₓN (0≦x≦0.6) and is what contains at least one or more ingredients selected from Mg, Be, and Zn in the range of 0.00001-10 mol % to this composite.

Item 294. The substrate for thin film formation as described in Item 292, or 293, wherein the thin film comprises as the main ingredients a composite expressed with the chemical formula of AlₓGa₁₋ₓN (0≦x≦0.6) and is what contains Si in the range of 0.00001-10 mol % to this composite.

Item 295. The substrate for thin film formation as described in Item 292, 293, or 294, wherein the thin film comprises as the main ingredients a composite expressed with the chemical formula of AlₓGa₁₋ₓN (0≦x≦0.6) and is what contains simultaneously at least one or more ingredients selected from Mg, Be, and Zn and Si in the range of 0.00001-10 mol % in total to this composite.

Item 296. The substrate for thin film formation as described in Item 288, 289, 290, or 291, wherein the thin film comprises as the main ingredients a composite expressed with the chemical formula of AlₓGa₁₋ₓN (0.6≦x≦1.0).

Item 297. The substrate for thin film formation as described in Item 296, wherein the thin film comprises as the main ingredients a composite expressed with the chemical formula of AlₓGa₁₋ₓN (0.6≦x≦1.0) and is what contains at least one or more ingredients selected from Mg, Be, and Zn in the range of 0.00001-0.5 mol % to this composite.

Item 298. The substrate for thin film formation as described in Item 296, or 297, wherein the thin film comprises as the main ingredients a composite expressed with the chemical formula of AlₓGa₁₋ₓN (0.6≦x≦1.0) and is what contains Si in the range of 0.00001-0.5 mol % to this composite.

Item 299. The substrate for thin film formation as described in Item 296, 297, or 298, wherein the thin film comprises as the main ingredients a composite expressed with the chemical formula of AlₓGa₁₋ₓN (0.6≦x≦1.0) and is what contains simultaneously at least one or more ingredients selected from Mg, Be, and Zn and Si in the range of 0.00001-10 mol % in total to this composite.

Item 300. The substrate for thin film formation in which a thin film comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, or 299, and the thickness of the thin film formed on a substrate is not less than 0.5 nm.

Item 301. The substrate for thin film formation as described in Item 300, wherein the thickness of the thin film formed is not less than 0.3 μm.

Item 302. The substrate for thin film formation as described in Item 300 or 301, wherein the thickness of the thin film formed is not less than 3.5 μm.

Item 303. The substrate for thin film formation as described in Item 300, 301, or 302, wherein the thickness of the thin film formed is not less than 10 μm.

Item 304. The substrate for thin film formation as described in Item 300, 301, 302, or 303, wherein the thickness of the thin film formed is not less than 50 μm.

Item 304. The substrate for thin film formation in which a thin film comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, or 304, and the thickness of the thin film formed on a substrate is not more than 1000 μm.

Item 306. The substrate for thin film formation as described in Item 305, wherein the thickness of the thin film formed is not more than 500 μm.

Item 307. The substrate for thin film formation in which a thin film comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, or 306, and at least a part of the thin film formed on a substrate is a single crystal, and the single crystal thin film has crystallinity not more than 3600 seconds as half width of the rocking curve of the X ray diffraction line from the lattice plane of a Miller Index (002).

Item 308. The substrate for thin film formation as described in Item 307, wherein the single crystal thin film has the crystallinity not more than 300 seconds as half width of the rocking curve of the X ray diffraction line from the lattice plane of a Miller Index (002).

Item 309. The substrate for thin film formation as described in Item 307 or 308, wherein the single crystal thin film has the crystallinity not more than 240 seconds as half width of the rocking curve of the X ray diffraction line from the lattice plane of a Miller Index (002).

Item 310. The substrate for thin film formation as described in Item 307, 308, or 309, wherein the single crystal thin film has the crystallinity not more than 200 seconds as half width of the rocking curve of the X ray diffraction line from the lattice plane of a Miller Index (002).

Item 311. The substrate for thin film formation as described in Item 307, 308, 309, or 310, wherein the single crystal thin film has the crystallinity not more than 150 seconds as half width of the rocking curve of the X ray diffraction line from the lattice plane of a Miller Index (002).

Item 312. The substrate for thin film formation as described in Item 307, 308, 309, 310, or 311, wherein the single crystal thin film has the crystallinity not more than 130 seconds as half width of the rocking curve of the X ray diffraction line from the lattice plane of a Miller Index (002).

Item 313. The substrate for thin film formation as described in Item 307, 308, 309, 310, 311, or 312, wherein the single crystal thin film has the crystallinity not more than 100 seconds as half width of the rocking curve of the X ray diffraction line from the lattice plane of a Miller Index (002).

Item 314. The substrate for thin film formation in which a thin film comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, or 313, and the thin film formed on a substrate is what was obtained using at least one or more materials selected from trimethyl gallium, trimethyl indium, and trimethyl aluminum as the main raw material and using at least one or more elements selected from ammonia, nitrogen, and hydrogen as a reactive gas.

Item 315. The substrate for thin film formation in which a thin film comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, or 313, and the thin film formed on a substrate is what was obtained by using at least one or more materials selected from gallium chloride, indium chloride, and aluminium chloride as the main raw material and using at least one or more elements selected from ammonia, nitrogen, and hydrogen as a reactive gas.

Item 316. A manufacture method of the substrate for thin film formation in which a thin film comprises at least one or more materials selected from a gallium nitride, an indium nitride, and an aluminum nitride as the main ingredients, and the substrate consists of a sintered compact which comprises an aluminum nitride as the main ingredients, the method comprises using as a raw material at least one of raw materials using respectively alone of either which is selected from what is made by reduction of an aluminum oxide and what is made by direct nitriding of metal aluminum, or using the mixture of what is made by reduction of an aluminum oxide and what is made by direct nitriding of metal aluminum, to form the sintered compact.

Item 317. A manufacture method of the substrate for thin film formation in which a thin film comprises at least one or more materials selected from a gallium nitride, an indium nitride, and an aluminum nitride as the main ingredients, and the substrate consists of a sintered compact which comprises an aluminum nitride as the main ingredients, the method comprises firing the powder compact or sintered compact which comprise an aluminum nitride as the main ingredients for not less than 10 minutes at the temperature not less than 1500 degrees C. in non-oxidizing atmosphere to form the sintered compact.

Item 318. The manufacture method of the substrate for thin film formation in which a thin film comprises at least one or more materials selected from a gallium nitride, an indium nitride, and an aluminum nitride as the main ingredients and was described in Item 316 or 317, and the substrate consists of a sintered compact which comprises an aluminum nitride as the main ingredients and is obtained by firing the powder compact or sintered compact which comprise an aluminum nitride as the main ingredients and is manufactured by using as a raw material at least one of raw materials using respectively alone of either which is selected from what is made by reduction of an aluminum oxide and what is made by direct nitriding of metal aluminum, or by using the mixture of what is made by reduction of an aluminum oxide and what is made by direct nitriding of metal aluminum, at the temperature not less than 1500 degrees C. for not less than 10 minutes in a non-oxidizing atmosphere.

Item 319. The manufacture method of the substrate for thin film formation as described in Item 316, 317, or 318, wherein the sintered compact which comprises an aluminum nitride as the main ingredients has optical permeability.

Item 320. The manufacture method of the substrate for thin film formation as described in Item 316, 317, 318, or 319, wherein the sintered compact which comprises an aluminum nitride as the main ingredients has the optical transmissivity not less than 1%.

Item 321. The manufacture method of the substrate for thin film formation as described in Item 320, wherein the sintered compact which comprises an aluminum nitride as the main ingredients has the optical transmissivity not less than 5%,

Item 322. The manufacture method of the substrate for thin film formation as described in Item 320 or 321, wherein the sintered compact which comprises an aluminum nitride as the main ingredients has the optical transmissivity not less than 10%.

Item 323. The manufacture method of the substrate for thin film formation as described in Item 320, 321, or 322, wherein the sintered compact which comprises an aluminum nitride as the main ingredients has the optical transmissivity not less than 20%.

Item 324. The manufacture method of the substrate for thin film formation as described in Item 320, 321, 322, or 323, wherein the sintered compact which comprises an aluminum nitride as the main ingredients has the optical transmissivity not less than 30%.

Item 325. The manufacture method of the substrate for thin film formation as described in Item 320, 321, 322, 323, or 324, wherein the sintered compact which comprises an aluminum nitride as the main ingredients has the optical transmissivity not less than 40%.

Item 326. The manufacture method of the substrate for thin film formation as described in Item 320, 321, 322, 323, 324, or 325, wherein the sintered compact which comprises an aluminum nitride as the main ingredients has the optical transmissivity not less than 50%.

Item 327. The manufacture method of the substrate for thin film formation as described in Item 320, 321, 322, 323, 324, 325, or 326, wherein the sintered compact which comprises an aluminum nitride as the main ingredients has the optical transmissivity not less than 60%.

Item 328. The manufacture method of the substrate for thin film formation as described in Item 320, 321, 322, 323, 324, 325, 326, or 327, wherein the sintered compact which comprises an aluminum nitride as the main ingredients has the optical transmissivity not less than 80%.

Item 329. The manufacture method of the substrate for thin film formation as described in Item 320, 321, 322, 323, 324, 325, 326, 327, or 328, wherein the sintered compact which comprises an aluminum nitride as the main ingredients has the optical transmissivity not less than 85%.

Item 330. The manufacture method of the substrate for thin film formation as described in Item 316, 317, 318, 319, 320, 321, 322, 323, 324, 325, 326, 327, 328, or 329, wherein it consists of a sintered compact which comprises an aluminum nitride as the main ingredients and which is obtained by firing the powder compact or sintered compact which comprise an aluminum nitride as the main ingredients at the temperature not less than 1500 degrees C. for not less than 10 minutes in a non-oxidizing atmosphere containing an aluminum nitride ingredient.

Item 331. The manufacture method of the substrate for thin film formation as described in Item 330, wherein it consists of a sintered compact which comprises an aluminum nitride as the main ingredients and is obtained by supplying an aluminum nitride ingredient into the non-oxidizing atmosphere which is a firing atmosphere from the powder compact or sintered compact which comprise an aluminum nitride as the main ingredients and are the fired thing, and by firing the fired thing at the temperature not less than 1500 degrees C. for not less than 10 minutes in this non-oxidizing atmosphere.

Item 332. The manufacture method of the substrate for thin film formation as described in Item 330, wherein it consists of a sintered compact which comprises an aluminum nitride as the main ingredients and is obtained by supplying an aluminum nitride ingredient into the non-oxidizing atmosphere which is a firing atmosphere from except the powder compact or sintered compact which comprise an aluminum nitride as the main ingredients and are the fired thing, and by firing the fired thing at the temperature not less than 1500 degrees C. for not less than 10 minutes in this non-oxidizing atmosphere.

Item 333. The manufacture method of the substrate for thin film formation as described in Item 330 or 331, wherein the powder compact or sintered compact which comprise an aluminum nitride as the main ingredients is fired by using the firing container or the firing implement which consist of a material which comprises an aluminum nitride as the main ingredients.

Item 334. The manufacture method of the substrate for thin film formation as described in Item 332, or 333, wherein the powder compact or sintered compact which comprise an aluminum nitride as the main ingredients and are a fired thing is fired by making at least one or more things selected from the powder comprising an aluminum nitride as the main ingredients, the powder compact comprising an aluminum nitride as the main ingredients, or the sintered compact comprising an aluminum nitride as the main ingredients exist simultaneously in the firing container or the firing implement.

Item 335. The manufacture method of the substrate for thin film formation as described in Item 330, 331, 332, 333, or 334, wherein the powder compact or sintered compact which comprise an aluminum nitride as the main ingredients is fired by using the firing container or the firing implement which consist of a material which comprises as the main ingredients at least one or more materials selected from aluminum nitride, tungsten, molybdenum, boron nitride, and carbon which coated an boron nitride.

Item 336. The manufacture method of the substrate for thin film formation as described in Item 316, 317, 318, 319, 320, 321, 322, 323, 324, 325, 326, 327, 328, 329, 330, 331, 332, 333, 334, or 335, wherein this sintered compact is fired under pressure by the hot press method or the hot isostatic press (HIP) method after the powder compact which comprises an aluminum nitride as the main ingredients is made into the sintered compact which comprises an aluminum nitride as the main ingredients by firing.

Item 337. The manufacture method of the substrate for thin film formation in which a thin film comprises at least one or more materials selected from a gallium nitride, an indium nitride, and an aluminum nitride as the main ingredients and was described in Item 316, 317, 318, 319, 320, 321, 322, 323, 324, 325, 326, 327, 328, 329, 330, 331, 332, 333, 334, 335, or 336, and the substrate is what heats the powder compact or sintered compact which comprise an aluminum nitride as the main ingredients at the temperature not less than 1750 degrees C. for not less than 3 hours in non-oxidizing atmosphere.

Item 338. The manufacture method of the substrate for thin film formation in which a thin film comprises at least one or more materials selected from a gallium nitride, an indium nitride, and an aluminum nitride as the main ingredients and was described in Item 316, 317, 318, 319, 320, 321, 322, 323, 324, 325, 326, 327, 328, 329, 330, 331, 332, 333, 334, 335, 336, or 337, and the substrate consists of a sintered compact which comprises an aluminum nitride as the main ingredients and which is obtained by making at least one or more ingredients selected from at least a rare earth element compound, an alkaline-earth-metals compound, and oxygen among the ingredients contained vaporize, remove, and decrease by firing the powder compact or sintered compact which comprise an aluminum nitride as the main ingredients and which contain at least one or more compounds selected from a rare earth element compound and an alkaline-earth-metals compound at the temperature not less than 1750 degrees C. for not less than 3 hours in non-oxidizing atmosphere.

Item 339. The manufacture method of the substrate for thin film formation as described in Item 337 or 338, wherein the firing temperature is not less than 1900 degrees C.

Item 340. The manufacture method of the substrate for thin film formation as described in Item 337, 338, or 339, wherein the firing temperature is not less than 2050 degrees C.

Item 341. The manufacture method of the substrate for thin film formation as described in Item 337, 338, 339, or 340, wherein the firing temperature is not less than 2100 degrees C.

Item 342. The manufacture method of the substrate for thin film formation in which a thin film comprises at least one or more materials selected from a gallium nitride, an indium nitride, and an aluminum nitride as the main ingredients and was described in Item 316, 317, 318, 319, 320, 321, 322, 323, 324, 325, 326, 327, 328, 329, 330, 331, 332, 333, 334, 335, 336, 337, 338, 339, 340, or 341, and the substrate consists of a sintered compact which comprises an aluminum nitride as the main ingredients and which is obtained by making at least one or more ingredients selected from at least a rare earth element compound, an alkaline-earth-metals compound, and oxygen among the ingredients contained vaporize, remove, and decrease by firing the powder compact or sintered compact which comprise an aluminum nitride as the main ingredients and which contain simultaneously at least one or more compounds selected from a rare earth element compound and an alkaline-earth-metals compound at the temperature not less than 1750 degrees C. for not less than 3 hours in non-oxidizing atmosphere.

Item 343. The manufacture method of the substrate for thin film formation in which a thin film comprises at least one or more materials selected from a gallium nitride, an indium nitride, and an aluminum nitride as the main ingredients and was described in Item 316, 317, 318, 319, 320, 321, 322, 323, 324, 325, 326, 327, 328, 329, 330, 331, 332, 333, 334, 335, 336, 337, 338, 339, 340, 341, or 342, and the substrate for forming the thin film consists of a sintered compact which comprises an aluminum nitride as the main ingredients and which is obtained by firing the powder compact comprising an aluminum nitride as the main ingredients, and the powder compact consists of a green sheet comprising an aluminum nitride raw material powder as the main ingredients.

Item 344. The manufacture method of the substrate for thin film formation in which a thin film comprises at least one or more materials selected from a gallium nitride, an indium nitride, and an aluminum nitride as the main ingredients and was described in Item 316, 317, 318, 319, 320, 321, 322, 323, 324, 325, 326, 327, 328, 329, 330, 331, 332, 333, 334, 335, 336, 337, 338, 339, 340, 341, 342, or 343, and the substrate for forming this thin film consists of a sintered compact which comprises an aluminum nitride as the main ingredients and which is obtained by firing furthermore the sintered compact obtained by firing the powder compact comprising an aluminum nitride as the main ingredients, and the powder compact consists of a green sheet comprising an aluminum nitride raw material powder as the main ingredients.

Item 345. The manufacture method of the substrate for thin film formation as described in Item 316, 317, 318, 319, 320, 321, 322, 323, 324, 325, 326, 327, 328, 329, 330, 331, 332, 333, 334, 335, 336, 337, 338, 339, 340, 341, 342, 343, or 344, wherein the firing is performed at the temperature not less than 1750 degrees C. for not less than 10 hours.

Item 346. The manufacture method of the substrate for thin film formation as described in Item 316, 317, 318, 319, 320, 321, 322, 323, 324, 325, 326, 327, 328, 329, 330, 331, 332, 333, 334, 335, 336, 337, 338, 339, 340, 341, 342, 343, 344, or 345, wherein the firing is performed at the temperature not less than 1900 degrees C. for not less than 6 hours.

Item 347. The manufacture method of the substrate for thin film formation as described in Item 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, or 346, wherein the firing is performed at the temperature not less than 2050 degrees C. for not less than 4 hours.

Item 348. The manufacture method of the substrate for thin film formation as described in Item 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, or 347, wherein the firing is performed at the temperature not less than 2100 degrees C. for not less than 3 hours.

Item 349. The manufacture method of the substrate for thin film formation as described in Item 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, or 348, wherein the firing atmosphere contains at least one or more elements selected from nitrogen, helium, neon, and argon.

Item 350. The manufacture method of the substrate for thin film formation as described in Item 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, or 349, wherein the firing atmosphere is a reduced atmosphere.

Item 351. The manufacture method of the substrate for thin film formation as described in Item 316, 317, 318, 319, 320, 321, 322, 323, 324, 325, 326, 327, 328, 329, 330, 331, 332, 333, 334, 335, 336, 337, 338, 339, 340, 341, 342, 343, 344, 345, 346, 347, 348, 349, or 350, wherein the firing atmosphere contains at least one or more elements selected from hydrogen, carbon, carbon monoxide, and hydrocarbon.

Item 352. The manufacture method of the substrate for thin film formation as described in Item 349, 350, or 351, wherein the firing atmosphere contains at least one or more elements selected from hydrogen, carbon, carbon monoxide, and hydrocarbon not less than 0.1 ppm.

Item 353. The manufacture method of the substrate for thin film formation as described in Item 316, 317, 318, 319, 320, 321, 322, 323, 324, 325, 326, 327, 328, 329,330, 331, 332, 333, 334, 335, 336, 337, 338, 339, 340, 341, 342, 343, 244, 345, 346, 347, 348, 349, 350, 351, or 352, wherein the minimum size of the fired powder compact or sintered compact which comprise an aluminum nitride as the main ingredients is not more than 8 mm.

Item 353. The manufacture method of the substrate for thin film formation as described in Item 316, 317, 318, 319, 320, 321, 322, 323, 324, 325, 326, 327, 328, 329, 330, 331, 332, 333, 334, 335, 336, 337, 338, 339, 340, 341, 342, 343, 244, 345, 346, 347, 348, 349, 350, 351, 352, or 353, wherein the fired powder compact or sintered compact which comprises an aluminum nitride as the main ingredients is board-like and the thickness is not more than 8 mm.

Item 355. A sintered compact which comprises an aluminum nitride as the main ingredients, in which the content of at least one or more ingredients selected from a rare earth element and an alkaline-earth metal is a total of not more than 0.5 weight % by element conversion, oxygen content is not more than 0.9 weight % by element conversion, AlN is not less than 95% as a crystal phase, the size of an aluminum nitride particle is not less than 5 μm, and having optical permeability.

Item 356. The sintered compact which comprises an aluminum nitride as the main ingredients and which was described in Item 355 and is characterized in that the content of at least one or more ingredients selected from a rare earth element and an alkaline-earth metal is a total of not more than 0.2 weight % by element conversion, and that the content of oxygen is not more than weight 0.5%.

Item 357. The sintered compact which comprises an aluminum nitride as the main ingredients and which was described in Item 355 or 356 and is characterized in that the content of at least one or more ingredients selected from a rare earth element and an alkaline-earth metal is a total of not more than 0.05 weight % by element conversion, and the content of oxygen is not more than weight 0.2%.

Item 358. The sintered compact which comprises an aluminum nitride as the main ingredients and which was described in Item 355, 356, or 357 and is characterized in that the content of at least one or more ingredients selected from a rare earth element and an alkaline-earth metal is a total of not more than 0.02 weight % by element conversion, and the content of oxygen is not more than weight 0.1%.

Item 359. The sintered compact which comprises an aluminum nitride as the main ingredients and which was described in Item 355, 356, 357, or 358 and is characterized in that the content of at least one or more ingredients selected from a rare earth element and an alkaline-earth metal is a total of not more than 0.005 weight % by element conversion, and the content of oxygen is not more than weight 0.05%.

Item 360. The sintered compact which comprises an aluminum nitride as the main ingredients and which was described in Item 355, 356, 357, 358, or 359 and is characterized in that the optical transmissivity is not less than 1%.

Item 361. The sintered compact which comprises an aluminum nitride as the main ingredients and which was described in Item 360 and is characterized in that the optical transmissivity is not less than 5%.

Item 362. The sintered compact which comprises an aluminum nitride as the main ingredients and which was described in Item 360 or 361 and is characterized in that the optical transmissivity is not less than 10%.

Item 363. The sintered compact which comprises an aluminum nitride as the main ingredients and which was described in Item 360, 361, or 362 and is characterized in that the optical transmissivity is not less than 20%.

Item 364. The sintered compact which comprises an aluminum nitride as the main ingredients and which was described in Item 360, 361, 362, or 363 and is characterized in that the optical transmissivity is not less than 30%.

Item 365. The sintered compact which comprises an aluminum nitride as the main ingredients and which was described in Item 360, 361, 362, 363, or 364 and is characterized in that the optical transmissivity is not less than 40%.

Item 366. The sintered compact which comprises an aluminum nitride as the main ingredients and which was described in Item 360, 361, 362, 363, 364, or 365 and is characterized in that the optical transmissivity is not less than 50%.

Item 367. The sintered compact which comprises an aluminum nitride as the main ingredients and which was described in Item 360, 361, 362, 363, 364, 365, or 366 and is characterized in that the optical transmissivity is not less than 60%.

Item 368. The sintered compact which comprises an aluminum nitride as the main ingredients and which was described in Item 360, 361, 362, 363, 364, 365, 366, or 367 and is characterized in that the optical transmissivity is not less than 80%.

Item 369. The sintered compact which comprises an aluminum nitride as the main ingredients and which was described in Item 360, 361, 362, 363, 364, 365, 366, 367, or 368 and is characterized in that the optical transmissivity is not less than 85%.

Item 370. The sintered compact which comprises an aluminum nitride as the main ingredients and which was described in Item 360, 361, 362, 363, 364, 365, 366, 367, 368, or 369 and is characterized in that the optical permeability or optical transmissivity is a thing in the light of the range of 200 nm-800 nm wavelength at least.

Item 371. The sintered compact which comprises an aluminum nitride as the main ingredients and which was described in Item 355, 356, 357, 358, 359, 360, 361, 362, 363, 364, 365, 366, 367, 368, 369, or 370 and is characterized in that AlN is contained not less than 98% as a crystal phase.

Item 372. The sintered compact which comprises an aluminum nitride as the main ingredients and which was described in Item 371 and is characterized in that the crystal phase is an AlN single phase substantially.

Item 373. The sintered compact which comprises an aluminum nitride as the main ingredients and which was described in Item 355, 356, 357, 358, 359, 360, 361, 362, 363, 364, 365, 366, 367, 368, 369, 370, 371, or 372 and is characterized in that the size of an aluminum nitride particle is not less than 8 μm.

Item 374. The sintered compact which comprises an aluminum nitride as the main ingredients and which was described in Item 373 and is characterized in that the size of an aluminum nitride particle is not less than 15 μm.

Item 375. The sintered compact which comprises an aluminum nitride as the main ingredients and which was described in Item 373 or 374 and is characterized in that the size of an aluminum nitride particle is not less than 25 μm.

Item 376. The sintered compact which comprises an aluminum nitride as the main ingredients and which was described in Item 355, 356, 357, 358, 359, 360, 361, 362, 363, 364, 365, 366, 367, 368, 369, 370, 371, 372, 373, 374, or 375 and is characterized in that the size of an aluminum nitride particle is not more than 100 μm.

Item 377. The sintered compact which comprises an aluminum nitride as the main ingredients and which was described in Item 355, 356, 357, 358, 359, 360, 361, 362, 363, 364, 365, 366, 367, 368, 369, 370, 371, 372, 373, 374, 375, or 376 and is characterized in that the thermal conductivity is not less than 200 W/mK in room temperature.

Item 378. The sintered compact which comprises an aluminum nitride as the main ingredients and which was described in Item 377 and is characterized in that the thermal conductivity is not less than 220 W/mK in room temperature.

Item 379. The sintered compact which comprises an aluminum nitride as the main ingredients and which was described in Item 355, 356, 357, 358, 359, 360, 361, 362, 363, 364, 365, 366, 367, 368, 369, 370, 371, 372, 373, 374, 375, 376, 377, or 378 and is characterized in that at least a part of the surface is the degree of smoothness not more than 2000 nm as average surface roughness Ra,

Item 380. The sintered compact which comprises an aluminum nitride as the main ingredients and which was described in Item 379 and is characterized in that at least a part of the surface is the degree of smoothness not more than 1000 nm as average surface roughness Ra.

Item 381. The sintered compact which comprises an aluminum nitride as the main ingredients and which was described in Item 379 or 380 and is characterized in that at least a part of the surface is the degree of smoothness not more than 100 nm as average surface roughness Ra.

Item 382. The sintered compact which comprises an aluminum nitride as the main ingredients and which was described in Item 379, 380, or 381 and is characterized in that at least a part of the surface is the degree of smoothness not more than 20 nm as average surface roughness Ra.

Item 383. The sintered compact which comprises an aluminum nitride as the main ingredients and which was described in Item 355, 356, 357, 358, 359, 360, 361, 362, 363, 364, 365, 366, 367, 368, 369, 370, 371, 372, 373, 374, 375, 376, 377, 378, 379, 380, 381, or 382 and is characterized in that at least a part of the surface is in at least one of the states selected from the as-fired one (as-fire), lap polish or specular surface polish.

Item 384. The sintered compact which comprises an aluminum nitride as the main ingredients and which was described in Item 383 and is characterized in that at least a part of the surface is in the state where specular surface polish was carried out.

Item 385. The sintered compact which comprises an aluminum nitride as the main ingredients and which was described in Item 355, 356, 357, 358, 359, 360, 361, 362, 363, 364, 365, 366, 367, 368, 369, 370, 371, 372, 373, 374, 375, 376, 377, 378, 379, 380, 381, 382, 383, or 384 and is characterized in that at least a part of the surface is the smoothness degree of more than 1000 nm as average surface roughness Ra.

Item 386. The sintered compact which comprises an aluminum nitride as the main ingredients and which was described in Item 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, or 385 and is characterized in that it is obtained by making at least one or more ingredients selected from at least a rare earth element compound, an alkaline-earth-metals compound, and oxygen among the ingredients contained vaporize, remove, and decrease by firing the powder compact or sintered compact which comprise an aluminum nitride as the main ingredients and which contain at least one or more compounds selected from a rare earth element compound and an alkaline-earth-metals compound for not less than 3 hours at the temperature not less than 1750 degrees C. in non-oxidizing atmosphere.

Item 387. The sintered compact which comprises an aluminum nitride as the main ingredients and which was described in Item 386 and is characterized in that the powder compact or sintered compact which comprise an aluminum nitride as the main ingredients and which contain simultaneously at least one or more compounds selected from a rare earth element compound and at least one or more compounds selected from alkaline-earth-metal compounds is fired for not less than 3 hours at the temperature not less than 1750 degrees C. in a non-oxidizing atmosphere.

Item 388. The sintered compact which comprises an aluminum nitride as the main ingredients and which was described in Item 386 or 387 and is characterized in that the raw material of the powder compact or sintered compact which are fired at the temperature not less than 1750 degrees C. for not less than 3 hours is either only one selected from what is made by the reduction method of an aluminum oxide and what is made by the direct nitriding method of metal aluminum, or what mixed the both of what is made by the reduction method of an aluminum oxide and what is made by the direct nitriding method of metal aluminum.

Item 389. The sintered compact which comprises an aluminum nitride as the main ingredients and which was described in Item 386, 387, or 388 and is characterized in that the firing is performed at the temperature not less than 1750 degrees C. for not less than 10 hours.

Item 390. The sintered compact which comprises an aluminum nitride as the main ingredients and which was described in Item 386, 387, 388, or 389 and is characterized in that the firing is performed at the temperature not less than 1900 degrees C. for not less than 6 hours.

Item 391. The sintered compact which comprises an aluminum nitride as the main ingredients and which was described in Item 386, 387, 388, or 389 and is characterized in that the firing is performed at the temperature not less than 2050 degrees C. for not less than 4 hours.

Item 392. The sintered compact which comprises an aluminum nitride as the main ingredients and which was described in Item 386, 387, 388, or 389 and is characterized in that the firing is performed at the temperature not less than 2100 degrees C. for not less than 3 hours.

Item 393. The sintered compact which comprises an aluminum nitride as the main ingredients and which was described in Item 386, 387, 388, 389, 390, 391, or 392 and is characterized in that the firing atmosphere contains at least one or more elements selected from nitrogen, helium, neon, and argon.

Item 394. The sintered compact which comprises an aluminum nitride as the main ingredients and which was described in Item 386, 387, 388, 389, 390, 391, 392, or 393 and is characterized in that the firing atmosphere is a reduced atmosphere.

Item 395. The sintered compact which comprises an aluminum nitride as the main ingredients and which was described in Item 386, 387, 388, 389, 390, 391, 392, 393, or 394 and is characterized in that the firing atmosphere contains at least one or more elements selected from hydrogen, carbon, carbon monoxide, and hydrocarbon.

Item 396. The sintered compact which comprises an aluminum nitride as the main ingredients and which was described in Item 393, 394, or 395 and is characterized in that the firing atmosphere contains at least one or more elements selected from hydrogen, carbon, carbon monoxide, and hydrocarbon not less than 0.1 ppm.

Item 397. The sintered compact which comprises an aluminum nitride as the main ingredients and which was described in Item 386, 387, 388, 389, 390, 391, 392, 393, 394, 395, or 396 and is characterized in that the minimum size of the powder compact or sintered compact which comprise an aluminum nitride as the main ingredients and are fired at the temperature not less than 1750 degrees C. for not less than 3 hours is not more than 8 mm.

Item 398. The sintered compact which comprises an aluminum nitride as the main ingredients and which was described in Item 386, 387, 388, 389, 390, 391, 392, 393, 394, 395, 396, or 397 and is characterized in that the powder compact or sintered compact which comprise an aluminum nitride as the main ingredients and are fired at the temperature not less than 1750 degrees C. for not less than 3 hours is board-like and the thickness is not more than 8 mm.

Item 399. A sintered compact which comprises a zinc oxide as the main ingredients and contains an aluminum ingredient at least and which has optical permeability.

Item 400. The sintered compact which comprises a zinc oxide as the main ingredients and which was described in Item 399 and is characterized in that a zinc oxide is contained not less than 55.0 mol % by ZnO conversion.

Item 401. The sintered compact which comprises a zinc oxide as the main ingredients and which was described in Item 399 or 400 and is characterized in that an aluminum ingredient is contained not more than 45.0 mol % by Al₂O₃ conversion.

Item 402. The sintered compact which comprises a zinc oxide as the main ingredients and which was described in Item 401 and is characterized in that an aluminum ingredient is contained in the range of 0.001 mol %-45.0 mol % by Al₂O₃ conversion.

Item 403. The sintered compact which comprises a zinc oxide as the main ingredients and which was described in Item 401 or 402 and is characterized in that an aluminum ingredient is contained in the range of 0.005 mol %-45.0 mol % by Al₂O₃ conversion.

Item 404. The sintered compact which comprises a zinc oxide as the main ingredients and which was described in Item 401, 402, or 403 and is characterized in that an aluminum ingredient is contained in the range of 0.02 mol %-45.0 mol % by Al₂O₃ conversion.

Item 405. The sintered compact which comprises a zinc oxide as the main ingredients and which was described in Item 401, 402, 403, or 404 and is characterized in that an aluminum ingredient is contained in the range of 0.08 mol %-35.0 mol % by Al₂O₃ conversion.

Item 406. The sintered compact which comprises a zinc oxide as the main ingredients and which was described in Item 399, 400, 401, 402, 403, or 404 and is characterized in that it contains an aluminum ingredient and contains simultaneously at least one or more ingredients selected from a rare earth element ingredient and a transition metal ingredient.

Item 407. The sintered compact which comprises a zinc oxide as the main ingredients and which was described in Item 406 and is characterized in that it contains an aluminum ingredient and contains simultaneously at least one or more ingredients selected from a rare earth element ingredient.

Item 408. The sintered compact which comprises a zinc oxide as the main ingredients and which was described in Item 406 or 407 and is characterized in that the rare earth element ingredient is at least one or more ingredients selected from yttrium, dysprosium, holmium, erbium, and ytterbium.

Item 409. The sintered compact which comprises a zinc oxide as the main ingredients and which was described in Item 406 and is characterized in that it contains an aluminum ingredient and contains simultaneously at least one or more ingredients selected from a transition metal ingredient.

Item 410. The sintered compact which comprises a zinc oxide as the main ingredients and which was described in Item 406, or 409 and is characterized in that the transition metal ingredient is at least one or more ingredients selected from iron and chromium.

Item 411. The sintered compact which comprises a zinc oxide as the main ingredients and which was described in Item 406, 407, 408, 409, or 410 and is characterized in that at least one or more ingredients selected from a rare earth element ingredient and a transition metal ingredient are contained not more than 10.0 mol % by oxide conversion.

Item 412. The sintered compact which comprises a zinc oxide as the main ingredients and which was described in Item 411 and is characterized in that at least one or more ingredients selected from a rare earth element ingredient are contained not more than 10.0 mol % by oxide conversion.

Item 413. The sintered compact which comprises a zinc oxide as the main ingredients and which was described in Item 411, or 412 and is characterized in that at least one or more ingredients selected from a transition metal ingredient is contained not more than 10.0 mol % by oxide conversion.

Item 414. The sintered compact which comprises a zinc oxide as the main ingredients and which was described in Item 406, 407, 408, 409, 410, 411, 412, or 413 and is characterized in that it contains an aluminum ingredient not more than 45.0 mol % by Al₂O₃ conversion and contains simultaneously at least one or more ingredients selected from a rare earth element ingredient not more than 10.0 mol % by oxide conversion.

Item 415. The sintered compact which comprises a zinc oxide as the main ingredients and which was described in Item 414 and is characterized in that at least one or more ingredients selected from a rare earth element ingredient are contained in the range of 0.0002 mol %-10.0 mol % by oxide conversion.

Item 416. The sintered compact which comprises a zinc oxide as the main ingredients and which was described in Item 414, or 415 and is characterized in that at least one or more ingredients selected from a rare earth element ingredient are contained in the range of 0.0006 mol %-6.0 mol % by oxide conversion.

Item 417. The sintered compact which comprises a zinc oxide as the main ingredients and which was described in Item 414, 415, or 416 and is characterized in that at least one or more ingredients selected from a rare earth element ingredient are contained in the range of 0.001 mol %-6.0 mol % by oxide conversion.

Item 418. The sintered compact which comprises a zinc oxide as the main ingredients and which was described in Item 414, 415, 416, or 417 and is characterized in that at least one or more ingredients selected from a rare earth element ingredient are contained in the range of 0.002 mol %-3.0 mol % by oxide conversion.

Item 419. The sintered compact which comprises a zinc oxide as the main ingredients and which was described in Item 406, 407, 408, 409, 410, 411, 412, 413, 414, 415, 416, 417, or 418 and is characterized in that an aluminum ingredient is contained in the range of 0.001 mol %-45.0 mol % by Al₂O₃ conversion, and at least one or more ingredients selected from a rare earth element ingredient are contained simultaneously.

Item 420. The sintered compact which comprises a zinc oxide as the main ingredients and which was described in Item 399, 400, 401, 402, 403, 404, 405, 406, 407, 408, 409, 410, 411, 412, 413, 414, 415,-416, 417, 418, or 419 and is characterized in that the optical transmissivity is not less than 1%.

Item 421. The sintered compact which comprises a zinc oxide as the main ingredients and which was described in Item 420 and is characterized in that the optical transmissivity is not less than 10%.

Item 422. The sintered compact which comprises a zinc oxide as the main ingredients and which was described in Item 420 or 421 and is characterized in that the optical transmissivity is not less than 20%.

Item 423. The sintered compact which comprises a zinc oxide as the main ingredients and which was described in Item 420, 421, or 422 and is characterized in that the optical transmissivity is not less than 30%.

Item 424. The sintered compact which comprises a zinc oxide as the main ingredients and which was described in Item 420, 421, 422, or 423 and is characterized in that the optical transmissivity is not less than 40%.

Item 425. The sintered compact which comprises a zinc oxide as the main ingredients and which was described in Item 420, 421, 422, 423, or 424 and is characterized in that the optical transmissivity is not less than 50%.

Item 426. The sintered compact which comprises a zinc oxide as the main ingredients and which was described in Item 420, 421, 422, 423, 424, or 425 and is characterized in that the optical transmissivity is not less than 60%.

Item 427. The sintered compact which comprises a zinc oxide as the main ingredients and which was described in Item 420, 421, 422, 423, 424, 425, or 426 and is characterized in that the optical transmissivity is not less than 80%.

Item 428. The sintered compact which comprises a zinc oxide as the main ingredients and which was described in Item 399, 420, 421, 422, 423, 424, 425, 426, or 427 and is characterized in that the optical permeability or optical transmissivity is a thing in the light of the range of 200 nm-800 nm wavelength at least.

Item 429. The sintered compact which comprises a zinc oxide as the main ingredients and which was described in Item 399, 400, 401, 402, 403, 404, 405, 406, 407, 408, 409, 410, 411, 412, 413, 414, 415, 416, 417, 418, 419, 420, 421, 422, 423, 424, 425, 426, 427, or 428 and is characterized in that it has electrical conductivity.

Item 430. The sintered compact which comprises a zinc oxide as the main ingredients and which was described in Item 429 and is characterized in that it has electrical conductivity not more than 1×10² Ω·cm as electric resistivity in room temperature.

Item 431. The sintered compact which comprises a zinc oxide as the main ingredients and which was described in Item 430 and is characterized in that it has electrical conductivity not more than 1×10 Ω·cm as electric resistivity in room temperature.

Item 432. The sintered compact which comprises a zinc oxide as the main ingredients and which was described in Item 430, or 431 and is characterized in that it has electrical conductivity not more than 1×10⁻² Ω·cm as electric resistivity in room temperature.

Item 433. The sintered compact which comprises a zinc oxide as the main ingredients and which was described in Item 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, or 432 and is characterized in that it has optical permeability and electrical conductivity.

Item 434. A thin film substrate in which the thin film comprises as the main ingredients at least one or more materials selected from a gallium nitride, an indium nitride, and an aluminum nitride, and is formed on the sintered compact which comprises an aluminum nitride as the main ingredients.

Item 435. The thin film substrate as described in Item 434, wherein the sintered compact which comprises an aluminum nitride as the main ingredients is substrate-like.

Item 436. The thin film substrate as described in Item 434 or 435, wherein the thin film which comprises as the main ingredients at least one or more materials selected from a gallium nitride, an indium nitride, and an aluminum nitride has at least one of the crystallized states selected from a single crystal, an amorphous state, a polycrystal, and an orientated polycrystal.

Item 437. The thin film substrate as described in Item 436, wherein at least a part of the thin film which comprises as the main ingredients at least one or more materials selected from a gallium nitride, an indium nitride, and an aluminum nitride is a single crystal.

Item 438. The thin film substrate in which a thin film which comprises as the main ingredients at least one or more materials selected from a gallium nitride, an indium nitride, and an aluminum nitride is formed on the substrate consisting of a sintered compact comprising an aluminum nitride as the main ingredients and was described in Item 434, 435, 436, or 437, and the sintered compact which comprises an aluminum nitride as the main ingredients has optical permeability.

Item 439. The thin film substrate as described in Item 434, 435, 436, 437, or 438, wherein the sintered compact which comprises an aluminum nitride as the main ingredients has the optical transmissivity not less than 1%.

Item 440. The thin film substrate as described in Item 439, wherein the sintered compact which comprises an aluminum nitride as the main ingredients has the optical transmissivity not less than 5%.

Item 441. The thin film substrate as described in Item 439 or 440, wherein the sintered compact which comprises an aluminum nitride as the main ingredients has the optical transmissivity not less than 10%.

Item 442. The thin film substrate as described in Item 439, 440, or 441, wherein the sintered compact which comprises an aluminum nitride as the main ingredients has the optical transmissivity not less than 20%.

Item 443. The thin film substrate as described in Item 439, 440, 441, or 442, wherein the sintered compact which comprises an aluminum nitride as the main ingredients has the optical transmissivity not less than 30%.

Item 444. The thin film substrate as described in Item 439, 440, 441, 442, or 443, wherein the sintered compact which comprises an aluminum nitride as the main ingredients has the optical transmissivity not less than 40%.

Item 445. The thin film substrate as described in Item 439, 440, 441, 442, 443, or 444, wherein the sintered compact which comprises an aluminum nitride as the main ingredients has the optical transmissivity not less than 60%.

Item 446. The thin film substrate as described in Item 439, 440, 441, 442, 443, 444, or 445, wherein the sintered compact which comprises an aluminum nitride as the main ingredients has the optical transmissivity not less than 80%.

Item 447. The thin film substrate as described in Item 439, 440, 441, 442, 443, 444, 445, or 446, wherein the sintered compact which comprises an aluminum nitride as the main ingredients has the optical transmissivity not less than 85%.

Item 448. The thin film substrate in which a thin film which comprises as the main ingredients at least one or more materials selected from a gallium nitride, an indium nitride, and an aluminum nitride is formed on the substrate consisting of a sintered compact comprising an aluminum nitride as the main ingredients and was described in Item 434, 435, 436, 437, 438, 439, 440, 441, 442, 443, 444, 445, 446, or 447, and the optical transmissivity of the sintered compact which comprises an aluminum nitride as the main ingredients is smaller than 1%.

Item 449. The thin film substrate as described in Item 434, 435, 436, 437, or 448, wherein the sintered compact which comprises an aluminum nitride as the main ingredients has the optical transmissivity of 0%.

Item 450. The thin film substrate as described in Item 434, 435, 436, 437, 438, 439, 440, 441, 442, 443, 444, 445, 446, 447, 448, or 449, wherein the optical permeability or optical transmissivity is a thing in the light of the range of 200 nm -800 nm wavelength at least.

Item 451. The thin film substrate in which a thin film which comprises as the main ingredients at least one or more materials selected from a gallium nitride, an indium nitride, and an aluminum nitride is formed on the substrate consisting of a sintered compact comprising an aluminum nitride as the main ingredients and was described in Item 434, 435, 436, 437, 438, 439, 440, 441, 442, 443, 444, 445, 446, 447, 448, 449, or 450, and the sintered compact which comprises an aluminum nitride as the main ingredients contains an aluminum nitride not less than 20 volume %.

Item 452. The thin film substrate as described in Item 451, wherein the sintered compact which comprises an aluminum nitride as the main ingredients contains an aluminum nitride not less than 50 volume %

Item 453. The thin film substrate as described in Item 451 or 452, wherein the sintered compact which comprises an aluminum nitride as the main ingredients contains at least one or more ingredients selected from a rare earth element or an alkaline-earth metal not more than 80 volume % by oxide conversion.

Item 454. The thin film substrate as described in Item 453, wherein the sintered compact which comprises an aluminum nitride as the main ingredients contains at least one or more ingredients selected from a rare earth element or an alkaline-earth metal not more than 50 volume % by oxide conversion.

Item 455. The thin film substrate as described in Item 453 or 454, wherein the sintered compact which comprises an aluminum nitride as the main ingredients contains at least one or more ingredients selected from a rare earth element or an alkaline-earth metal not more than 25 volume % by oxide conversion.

Item 456. The thin film substrate as described in Item 453, 454, or 455, wherein the sintered compact which comprises an aluminum nitride as the main ingredients contains simultaneously at least one or more ingredients selected from a rare earth element and at least one or more ingredients selected from an alkaline earth metal.

Item 456. The thin film substrate as described in Item 451, 452, 453, 454, 455, or 456, wherein the sintered compact which comprises an aluminum nitride as the main ingredients contains at least one or more ingredients selected from an alkaline metal or silicon not more than 50 volume % by oxide conversion.

Item 457. The thin film substrate as described in Item 457, wherein the sintered compact which comprises an aluminum nitride as the main ingredients contains at least one or more ingredients selected from an alkaline metal or silicon not more than 30 volume % by oxide conversion.

Item 459. The thin film substrate as described in Item 457 or 458, wherein the sintered compact which comprises an aluminum nitride as the main ingredients contains at least one or more ingredients selected from an alkaline metal or silicon not more than 20 volume % by oxide conversion.

Item 460. The thin film substrate as described in Item 457, 458, or 459, wherein the sintered compact which comprises an aluminum nitride as the main ingredients contains at least one or more ingredients selected from an alkaline metal or silicon not more than 10 volume % by oxide conversion.

Item 461. The thin film substrate as described in Item 453, 454, 455, 456, 457, 458, 459, or 460, wherein the sintered compact which comprises an aluminum nitride as the main ingredients contains at least one or more ingredients selected from an alkaline metal or silicon and contains simultaneously at least one or more ingredients selected from a rare earth element or an alkaline-earth metal.

Item 462. The thin film substrate as described in Item 451, 452, 453, 454, 455, 456, 457, 458, 459, 460, or 461, wherein the sintered compact which comprises an aluminum nitride as the main ingredients contains at least one or more ingredients selected from Mo, W, V (vanadium), Nb, Ta, Ti, and carbon not more than 80 volume % by element conversion.

Item 463. The thin film substrate as described in Item 462, wherein the sintered compact which comprises an aluminum nitride as the main ingredients contains at least one or more ingredients selected from Mo, W, V (vanadium), Nb, Ta, Ti, and carbon not more than 50 volume % by element conversion.

Item 464. The thin film substrate as described in Item 462 or 463, wherein the sintered compact which comprises an aluminum nitride as the main ingredients contains at least one or more ingredients selected from Mo, W, V, Nb, Ta, Ti, and carbon not more than 25 volume % by element conversion.

Item 465. The thin film substrate as described in Item 453, 454, 455, 456, 462, 463, or 464, wherein the sintered compact which comprises an aluminum nitride as the main ingredients contains at least one or more ingredients selected from Mo, W, V, Nb, Ta, Ti, and carbon and contains simultaneously at least one or more ingredients selected from a rare earth element or an alkaline-earth metal.

Item 466. The thin film substrate as described in Item 451, 452, 453, 454, 455, 456, 457, 458, 459, 460, 461, 462, 463, 464, or 465, wherein the sintered compact which comprises an aluminum nitride as the main ingredients contains a transition metal ingredient other than a rare earth element and Mo, W, V (vanadium), Nb, Ta, and Ti not more than 80 weight % by element conversion.

Item 467. The thin film substrate as described in Item 466, wherein the sintered compact which comprises an aluminum nitride as the main ingredients contains a transition metal ingredient other than a rare earth element and Mo, W, V (vanadium), Nb, Ta, and Ti not more than 50 weight % by element conversion.

Item 468. The thin film substrate as described in Item 466 or 467, wherein the sintered compact which comprises an aluminum nitride as the main ingredients contains a transition metal ingredient other than a rare earth element and Mo, W, V, Nb, Ta, and Ti not more than 30 weight % by element conversion.

Item 469. The thin film substrate as described in Item 453, 454, 455, 456, 466, 467, or 468, wherein the sintered compact which comprises an aluminum nitride as the main ingredients contains a transition metal ingredient other than a rare earth element and Mo, W, V, Nb, Ta, and Ti and contains simultaneously at least one or more ingredients selected from a rare earth element or an alkaline-earth metal.

Item 470. The thin film substrate as described in Item 466, 467, 468, or 469, wherein the transition metal ingredient other than a rare earth element and Mo, W, V, Nb, Ta, and Ti is at least one or more ingredients selected from iron, nickel, chromium, manganese, zirconium, hafnium, cobalt, copper, and zinc.

Item 471. The thin film substrate as described in Item 451, 452, 453, 454, 455, 456, 457, 458, 459, 460, 461, 462, 463, 464, 465, 466, 467, 468, 469, or 470, wherein the sintered compact which comprises an aluminum nitride as the main ingredients contains oxygen not more than 30 weight %.

Item 472. The thin film substrate as described in Item 471, wherein the sintered compact which comprises an aluminum nitride as the main ingredients contains oxygen not more than 25 weight %.

Item 473. The thin film substrate as described in Item 471 or 472, wherein the sintered compact which comprises an aluminum nitride as the main ingredients contains oxygen not more than 10 weight %.

Item 474. The thin film substrate as described in Item 453, 454, 455, 456, 471, 472, or 473, wherein the sintered compact which comprises an aluminum nitride as the main ingredients contains oxygen and contains simultaneously at least one or more ingredients selected from a rare earth element or an alkaline-earth metal.

Item 475. The thin film substrate as described in Item 451, 452, 453, 454, 455, 456, 457, 458, 459, 460, 461, 462, 463, 464, 465, 466, 467, 468, 469, 470, 471, 472, 473, or 474, wherein the sintered compact which comprises an aluminum nitride as the main ingredients contains ALON not more than 80%.

Item 476. Thin film substrate as described in Item 475, wherein the sintered compact which comprises an aluminum nitride as the main ingredients contains ALON not more than 50%.

Item 477. One of thin film substrate as described in Item 475 or 476, wherein the sintered compact which comprises an aluminum nitride as the main ingredients contains ALON not more than 20%.

Item 478. One of thin film substrate as described in Item 453, 454, 455, 456, 475, 476, or 477, wherein the sintered compact which comprises an aluminum nitride as the main ingredients contains ALON and contains simultaneously at least one or more ingredients selected from a rare earth element or an alkaline-earth metal.

Item 479. The thin film substrate in which a thin film which comprises as the main ingredients at least one or more materials selected from a gallium nitride, an indium nitride, and an aluminum nitride is formed on the substrate consisting of a sintered compact comprising an aluminum nitride as the main ingredients and was described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, or 478, and the thermal conductivity of the sintered compact which comprises an aluminum nitride as the main ingredients is not less than 50 W/mK in room temperature.

Item 480. The thin film substrate as described in Item 479, wherein the thermal conductivity of this sintered compact which comprises an aluminum nitride as the main ingredients is not less than 100 W/mK in room temperature.

Item 481. The thin film substrate as described in Item 479 or 480, wherein the thermal conductivity of this sintered compact which comprises an aluminum nitride as the main ingredients is not less than 150 W/mK in room temperature.

Item 482. The thin film substrate as described in Item 479, 480, or 481, wherein the thermal conductivity of this sintered compact which comprises an aluminum nitride as the main ingredients is not less than 170 W/mK in room temperature.

Item 483. The thin film substrate as described in Item 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, or 482, wherein the sintered compact which comprises an aluminum nitride as the main ingredients contains at least one or more ingredients selected from a rare earth element and an alkaline-earth metal not more than 0.5 weight % in total by element conversion and contains oxygen not more than 0.9 weight %.

Item 484. The thin film substrate as described in Item 483, wherein the sintered compact which comprises an aluminum nitride as the main ingredients contains at least one or more ingredients selected from a rare earth element and an alkaline-earth metal not more than 0.2 weight % in total by element conversion and contains oxygen not more than 0.5 weight %.

Item 485. The thin film substrate as described in Item 483 or 484, wherein the sintered compact which comprises an aluminum nitride as the main ingredients contains at least one or more ingredients selected from a rare earth element and an alkaline-earth metal not more than 0.05 weight % in total by element conversion and contains oxygen not more than 0.2 weight %.

Item 486. The thin film substrate as described in Item 483, 484, or 485, wherein the sintered compact which comprises an aluminum nitride as the main ingredients contains at least one or more ingredients selected from a rare earth element and an alkaline-earth metal not more than 0.02 weight % in total by element conversion and contains oxygen not more than 0.1 weight %.

Item 487. The thin film substrate as described in Item 483, 484, 485, or 486, wherein the sintered compact which comprises an aluminum nitride as the main ingredients contains at least one or more ingredients selected from a rare earth element and an alkaline-earth metal not more than 0.005 weight % in total by element conversion and contains oxygen not more than 0.05 weight %.

Item 488. The thin film substrate as described in Item 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, or 487, wherein the sintered compact which comprises an aluminum nitride as the main ingredients contains at least one or more ingredients selected from an alkaline metal or silicon not more than 0.2 weight % in total by element conversion and contains oxygen not more than 0.9 weight %.

Item 489. The thin film substrate as described in Item 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, or 488, wherein the sintered compact which comprises an aluminum nitride as the main ingredients contains at least one or more ingredients selected from Mo, W, V (vanadium), Nb, Ta, Ti, and carbon not more than 0.2 weight % in total by element conversion and contains oxygen not more than 0.9 weight %.

Item 490. The thin film substrate as described in Item 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, or 489, wherein the sintered compact which comprises an aluminum nitride as the main ingredients contains at least one or more ingredients selected from Fe, Ni, Co, and Mn not more than 0.2 weight % in total by element conversion and contains oxygen not more than 0.9 weight %.

Item 491. The thin film substrate as described in Item 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, or 490, wherein the sintered compact which comprises an aluminum nitride as the main ingredients contains AlN not less than 95% as a crystal phase.

Item 492. The thin film substrate as described in Item 491, wherein the sintered compact which comprises an aluminum nitride as the main ingredients contains AlN not less than 98% as a crystal phase.

Item 493. The thin film substrate as described in Item 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, or 492, wherein the crystal phase of a sintered compact which comprises an aluminum nitride as the main ingredients consists of an AlN single phase substantially.

Item 494. The thin film substrate as described in Item 451, 452, 453, 454, 455, 456, 457, 458, 459, 460, 461, 462, 463, 464, 465, 466, 467, 468,469, 470, 471, 472, 473, 474, 475, 476, 477, 478, 479, 480, 481, 482, 483, 484, 485, 486, 487, 488, 489, 490, 491, 492, or 493, wherein the thermal conductivity of a sintered compact which comprises an aluminum nitride as the main ingredients is not less than 200 W/mK in room temperature.

Item 495. The thin film substrate as described in Item 494, wherein the thermal conductivity of a sintered compact which comprises an aluminum nitride as the main ingredients is not less than 220 W/mK in room temperature.

Item 496. The thin film substrate as described in Item 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, or 495, wherein the sintered compact which comprises an aluminum nitride as the main ingredients is relative density not less than 95%.

Item 497. The thin film substrate as described in Item 496, wherein the sintered compact which comprises an aluminum nitride as the main ingredients is relative density not less than 98%.

Item 498. The thin film substrate as described in Item 451, 452, 453, 454, 455, 456, 457, 458, 459, 460, 461, 462, 463, 464, 465, 466,467, 468, 469, 470, 471, 472, 473, 474, 475, 476, 477, 478, 479, 480, 481, 482, 483, 484, 485, 486, 487, 488, 489, 490, 491, 492, 493, 494, 495, 496, or 497, wherein the pore in the sintered compact which comprises an aluminum nitride as the main ingredients is not more than 1 μm.

Item 499. The thin film substrate as described in Item 451, 452, 453, 454, 455, 456, 457, 458, 459, 460, 461, 462, 463, 464, 465, 466,467,468, 469, 470, 471, 472, 473, 474, 475, 476, 477, 478, 479, 480, 481, 482, 483, 484, 485, 486, 487, 488, 489, 490, 491, 492, 493, 494, 495, 496, 497, or 498, wherein the size of an aluminum nitride particle in the sintered compact which comprises an aluminum nitride as the main ingredients is an average of not less than 1 μm.

Item 500. The thin film substrate as described in Item 499, wherein the size of an aluminum nitride particle in the sintered compact which comprises an aluminum nitride as the main ingredients is an average of not less than 5 μm.

Item 501. The thin film substrate as described in Item 499 or 500, wherein the size of an aluminum nitride particle in the sintered compact which comprises an aluminum nitride as the main ingredients is an average of not less than 8 μm.

Item 502. The thin film substrate as described in Item 499, 500, or 501, wherein the size of an aluminum nitride particle in the sintered compact which comprises an aluminum nitride as the main ingredients is an average of not less than 15 μm.

Item 503. The thin film substrate as described in Item 499, 500, 501, or 502, wherein the size of an aluminum nitride particle in the sintered compact which comprises an aluminum nitride as the main ingredients is an average of not less than 25 μm.

Item 504. The thin film substrate as described in Item 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, or 503, wherein the size of an aluminum nitride particle in the sintered compact which comprises an aluminum nitride as the main ingredients is an average of not more than 100 μm.

Item 505. The thin film substrate in which a thin film which comprises as the main ingredients at least one or more materials selected from a gallium nitride, an indium nitride, and an aluminum nitride is formed on the substrate consisting of a sintered compact comprising an aluminum nitride as the main ingredients and was described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, or 504, and the sintered compact which comprises an aluminum nitride as the main ingredients is a smooth nature not more than 2000 nm as average surface roughness Ra.

Item 506. The thin film substrate as described in Item 505, wherein the surface of the sintered compact which comprises a aluminum nitride as the main ingredients is a smooth nature not more than 1000 nm as average surface roughness Ra.

Item 507. The thin film substrate as described in Item 505 or 506, wherein the surface of the sintered compact which comprises a aluminum nitride as the main ingredients is a smooth nature not more than 100 nm as average surface roughness Ra.

Item 508. The thin film substrate as described in Item 505, 506, or 507, wherein the surface of the sintered compact which comprises a aluminum nitride as the main ingredients is a smooth nature not more than 50 nm as average surface roughness Ra.

Item 509. The thin film substrate as described in Item 505, 506, 507, or 508, wherein the surface of the sintered compact which comprises a aluminum nitride as the main ingredients is a smooth nature not more than 20 nm as average surface roughness Ra.

Item 510. The thin film substrate in which a thin film which comprises as the main ingredients at least one or more materials selected from a gallium nitride, an indium nitride, and an aluminum nitride is formed on the substrate consisting of a sintered compact comprising an aluminum nitride as the main ingredients and was described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, or 504, and the sintered compact which comprises an aluminum nitride as the main ingredients has a smooth nature of more than 2000 nm as average surface roughness Ra.

Item 511. The thin film substrate in which a thin film which comprises as the main ingredients at least one or more materials selected from a gallium nitride, an indium nitride, and an aluminum nitride is formed on the substrate consisting of a sintered compact comprising an aluminum nitride as the main ingredients and was described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 50, 506, 507, 508, 509, or 510, and the sintered compact which comprises an aluminum nitride as the main ingredients has at least one of the surface state selected from the as-fired one (as-fire), lap polish, or specular surface polish.

Item 512. The thin film substrate as described in Item 511, wherein the sintered compact which comprises an aluminum nitride as the main ingredients has the surface state on which specular surface polish was carried out.

Item 513. The thin film substrate in which a thin film which comprises as the main ingredients at least one or more materials selected from a gallium nitride, an indium nitride, and an aluminum nitride is formed on the substrate consisting of a sintered compact comprising an aluminum nitride as the main ingredients and was described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, or 512, and the thickness of the sintered compact which comprises an aluminum nitride as the main ingredients is not more than 8.0 mm.

Item 514. The thin film substrate as described in Item 513, wherein the thickness of the sintered compact which comprises an aluminum nitride as the main ingredients is not more than 5.0 mm.

Item 515. The thin film substrate as described in Item 513 or 514, wherein the thickness of the sintered compact which comprises an aluminum nitride as the main ingredients is not more than 2.5 mm.

Item 516. The thin film substrate as described in Item 513, 514. or 515, wherein the thickness of the sintered compact which comprises an aluminum nitride as the main ingredients is not more than 1.0 mm.

Item 517. The thin film substrate in which a thin film which comprises as the main ingredients at least one or more materials selected from a gallium nitride, an indium nitride, and an aluminum nitride is formed on the substrate consisting of a sintered compact comprising an aluminum nitride as the main ingredients and was described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, or 516, and the thickness of the sintered compact which comprises an aluminum nitride as the main ingredients is not less than 0.01 mm.

Item 518. The thin film substrate as described in Item 517, wherein the thickness of the sintered compact which comprises an aluminum nitride as the main ingredients is not less than 0.02 mm.

Item 519. The thin film substrate as described in Item 517 or 518, wherein the thickness of the sintered compact which comprises an aluminum nitride as the main ingredients is not less than 0.05 mm.

Item 520. The thin film substrate as described in Item 513, 514, 515, 516, 517, 518, or 519, wherein the sintered compact which comprises an aluminum nitride as the main ingredients is the thickness not more than 8.0 mm and the optical transmissivity not less than 1%.

Item 521. The thin film substrate as described in Item 513, 514, 515, 516, 517, 518, 519, or 520, wherein the sintered compact which comprises an aluminum nitride as the main ingredients is the thickness not less than 0.01 mm and the optical transmissivity not less than 40%.

Item 522. The thin film substrate in which a thin film which comprises as the main ingredients at least one or more materials selected from a gallium nitride, an indium nitride, and an aluminum nitride is formed on the substrate consisting of a sintered compact comprising an aluminum nitride as the main ingredients and was described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, or 521, and the sintered compact which comprises an aluminum nitride as the main ingredients has a conduction via.

Item 523. The thin film substrate in which a thin film which comprises as the main ingredients at least one or more materials selected from a gallium nitride, an indium nitride, and an aluminum nitride is formed on the substrate consisting of a sintered compact comprising an aluminum nitride as the main ingredients and was described in Item 522, and the sintered compact which comprises an aluminum nitride as the main ingredients has a substrate-like shape and a conduction via.

Item 524. The thin film substrate as described in Item 522 or 523, wherein the conduction via is formed in the sintered compact which comprises an aluminum nitride as the main ingredients so that the up-and-down surface of a substrate may be connected electrically.

Item 525. The thin film substrate as described in Item 522, 523, or 524, wherein the conduction via consists of a material that comprises as the main ingredients at least one or more elements selected from gold, silver, copper, aluminum, iron, cobalt, nickel, ruthenium, rhodium, palladium, osmium, iridium, platinum, molybdenum, tungsten, chromium, titanium, titanium nitride, and zirconium nitride.

Item 526. The thin film substrate as described in Item 525, wherein the conduction via comprises as the main ingredients at least one or more elements selected from gold, silver, copper, aluminum, iron, cobalt, nickel, ruthenium, rhodium, palladium, osmium, iridium, platinum, molybdenum, tungsten, chromium, titanium, titanium nitride, and zirconium nitride and contains furthermore at least one or more materials selected from aluminum nitride, silicon carbide, silicon nitride, zinc oxide, beryllium oxide, aluminum oxide, rare earth element compound, and alkaline-earth-metals compound.

Item 527. The thin film substrate as described in Item 525 or 526, wherein the conduction via consists of a material that comprises as the main ingredients at least one or more elements selected from molybdenum, tungsten, copper, titanium nitride, and zirconium nitride.

Item 528. The thin film substrate as described in Item 525, 526, or 527, wherein the conduction via comprises as the main ingredients at least one or more elements selected from molybdenum, tungsten, copper, titanium nitride, and zirconium nitride and contains further at least one or more ingredients selected from aluminum nitride, aluminum oxide, rare earth element compound, and alkaline-earth-metals compound.

Item 529. The thin film substrate as described in Item 522, 523, 524, 525, 526, 527, or 528, wherein the conduction via consists of a conductive material of not more than 1×10⁻³ Ω·cm as electric resistivity in room temperature.

Item 530. The thin film substrate as described in Item 529, wherein the conduction via consists of a conductive material of not more than 1×10⁻⁴ Ω·cm as electric resistivity in room temperature.

Item 531. The thin film substrate as described in Item 529 or 530, wherein the conduction via consists of a conductive material of not more than 1×10⁻⁵ Ω·cm as electric resistivity in room temperature.

Item 532. The thin film substrate as described in Item 522, 523, 524, 525, 526, 527, 528, 529, 530, or 531, wherein the size of a conduction via is not more than 500 μm.

Item 533. The thin film substrate as described in Item 532, wherein the size of a conduction via is not more than 250 μm.

Item 534. The thin film substrate as described in Item 532 or 533, wherein the size of a conduction via is not more than 100 μm.

Item 535. The thin film substrate as described in Item 532, 533, or 534, wherein the size of a conduction via is not more than 50 μm.

Item 536. The thin film substrate as described in Item 532, 533, 534,or 535, wherein the size of a conduction via is not more than 25 μm.

Item 537. The thin film substrate as described in Item 522, 523, 524, 525, 526, 527, 528, 529, 530, 531, 532, 533, 534, 535, or 536, wherein the size of a conduction via is not less than 1 μm.

Item 538. The thin film substrate as described in Item 522, 523, 524, 525, 526, 527, 528, 529, 530, 531, 532, 533, 534, 535, 536, or 537, wherein the thin film is formed on the surface of a conduction via.

Item 539. The thin film substrate in which a thin film which comprises as the main ingredients at least one or more materials selected from a gallium nitride, an indium nitride, and an aluminum nitride is formed on the substrate consisting of a sintered compact comprising an aluminum nitride as the main ingredients and was described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, or 538, and the thin film conductivity material is being formed in the sintered compact which comprises an aluminum nitride as the main ingredients.

Item 540. The thin film substrate as described in Item 539, wherein the thin film conductivity material is being formed at least on the surface of the sintered compact which comprises an aluminum nitride as the main ingredients.

Item 541. The thin film substrate in which a thin film which comprises as the main ingredients at least one or more materials selected from a gallium nitride, an indium nitride, and an aluminum nitride is formed on the substrate consisting of a sintered compact comprising an aluminum nitride as the main ingredients and was described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, or 540, and the thin film conductivity material is being formed in the surface and/or inside of the thin film.

Item 542. The thin film substrate in which a thin film which comprises as the main ingredients at least one or more materials selected from a gallium nitride, an indium nitride, and an aluminum nitride was formed on the substrate consisting of a sintered compact comprising an aluminum nitride as the main ingredients and was described in Item 539, 540, or 54, and the thin film conductivity material is being formed on the sintered compact which comprises an aluminum nitride as the main ingredients, and the thin film conductivity material is being formed furthermore in the surface and/or inside of a thin film which comprises as the main ingredients at least one or more materials selected from a gallium nitride, an indium nitride, and an aluminum nitride.

Item 543. The thin film substrate as described in Item 539, 540, 541, or 542, wherein the thin film conductivity material consists of at least one or more materials selected from metal, alloy, and metal nitride.

Item 544. The thin film substrate as described in Item 539, 540, 541, 542, or 543, wherein the thin film conductivity material comprises as the main ingredients at least one or more elements selected from gold, silver, copper, aluminum, iron, cobalt, nickel, ruthenium, rhodium, palladium, osmium, iridium, platinum, tantalum, molybdenum, tungsten, chromium, titanium, nickel chromium alloy, titanium nitride, zirconium nitride, and tantalum nitride.

Item 545. The thin film substrate as described in Item 539, 540, 541, 542, 543, or 544, wherein the thin film conductivity material is being constituted with at least two or more layers.

Item 546. The thin film substrate as described in Item 539, 540, 541, 542, 543, 544, or 545, wherein the thickness of a thin film conductivity material is not more than 20 μm.

Item 547. The thin film substrate as described in Item 539, 540, 541, 542, 543, 544, 545, or 546, wherein the junction strength between the thin film conductivity material and the thin film which comprises as the main ingredients at least one or more materials selected from a gallium nitride, an indium nitride, and an aluminum nitride is not less than 2 Kg/mm².

Item 548. A thin film substrate in which the thin film comprises as the main ingredients at least one or more materials selected from a gallium nitride, an indium nitride, and an aluminum nitride, and is formed on the sintered compact which comprises as the main ingredients a ceramic material which has at least one of the crystal structures selected from a hexagonal system or a trigonal system.

Item 549. The thin film substrate as described in Item 548, wherein the sintered compact which comprises as the main ingredients a ceramic material which has at least one of the crystal structures selected from a hexagonal system or a trigonal system is substrate-like.

Item 550. The thin film substrate as described in Item 548 or 549, wherein the sintered compact which comprises as the main ingredients a ceramic material which has at least one of the crystal structures selected from a hexagonal system or a trigonal system is at least one selected from a silicon carbide, a silicon nitride, a beryllium oxide, a zinc oxide, and an aluminum oxide.

Item 551. The thin film substrate as described in Item 548, 549, or 550, wherein the sintered compact which comprises as the main ingredients a ceramic material which has at least one of the crystal structures selected from a hexagonal system or a trigonal system is the sintered compact which comprises a zinc oxide as the main ingredients.

Item 552. The thin film substrate as described in Item 550 or 551, wherein the sintered compact which comprises a zinc oxide as the main ingredients has optical permeability.

Item 553. The thin film substrate as described in Item 550, 551, or 552, wherein the sintered compact which comprises a zinc oxide as the main ingredients has the optical transmissivity not less than 1%.

Item 554. The thin film substrate as described in Item 553, wherein the sintered compact which comprises a zinc oxide as the main ingredients has the optical transmissivity not less than 10%.

Item 555. The thin film substrate as described in Item 553 or 554, wherein the sintered compact which comprises a zinc oxide as the main ingredients has the optical transmissivity not less than 20%.

Item 556. The thin film substrate as described in Item 553, 554, or 555, wherein the sintered compact which comprises a zinc oxide as the main ingredients has the optical transmissivity not less than 30%.

Item 557. The thin film substrate as described in Item 553, 554, 555, or 556, wherein the sintered compact which comprises a zinc oxide as the main ingredients has the optical transmissivity not less than 40%.

Item 558. The thin film substrate as described in Item 553, 554, 555, 556, or 557, wherein the sintered compact which comprises a zinc oxide as the main ingredients has the optical transmissivity not less than 50%.

Item 559. The thin film substrate as described in Item 553, 554, 555, 556, 557, or 558, wherein the sintered compact which comprises a zinc oxide as the main ingredients has the optical transmissivity not less than 60%.

Item 560. The thin film substrate as described in Item 553, 554, 555, 556, 557, 558, or 559, wherein the sintered compact which comprises a zinc oxide as the main ingredients has the optical transmissivity not less than 80%.

Item 561. The thin film substrate in which a thin film which comprises as the main ingredients at least one or more materials selected from a gallium nitride, an indium nitride, and an aluminum nitride is formed on the substrate consisting of a sintered compact comprising a zinc oxide as the main ingredients and was described in Item 550 or 551, and the optical transmissivity of the sintered compact which comprises a zinc oxide as the main ingredients is smaller than 1%.

Item 562. The thin film substrate as described in Item 561, wherein the sintered compact which comprises a zinc oxide as the main ingredients is the optical transmissivity of 0%.

Item 563. The thin film substrate as described in Item 550, 551, 552, 553, 554, 555, 556, 557, 558, 559, 560, 561, or 562, wherein the sintered compact which comprises a zinc oxide as the main ingredients has electrical conductivity.

Item 564. The thin film substrate as described in Item 550, 551, 552, 553, 554, 555, 556, 557, 558, 559, 560, 561, 562, or 563, wherein the sintered compact which comprises a zinc oxide as the main ingredients is electric resistivity not more than 1×10² Ω·cm in room temperature.

Item 565. The thin film substrate as described in Item 550, 551, 552, 553, 554, 555, 556, 557, 558, 559, 560, 561, 562, 563, or 564, wherein the sintered compact which comprises a zinc oxide as the main ingredients has optical permeability and has electrical conductivity.

Item 566. The thin film substrate as described in Item 550, 551, 552, 553, 554, 555, 556, 557, 558, 559, 560, 561, 562, 563, 564, or 565, wherein the sintered compact which comprises a zinc oxide as the main ingredients contains an aluminum ingredient at least.

Item 567. The thin film substrate as described in Item 550, 551, 552, 553, 554, 555, 556, 557, 558, 559, 560, 561, 562, 563, 564, 565, or 566, wherein the sintered compact which comprises a zinc oxide as the main ingredients contains a zinc oxide ingredient not less than 55.0 mol % by ZnO conversion.

Item 568. The thin film substrate as described in Item 550, 551, 552, 553, 554, 555, 556, 557, 558, 559, 560, 561, 562, 563, 564, 565, 566, or 567, wherein the sintered compact which comprises a zinc oxide as the main ingredients contains an aluminum ingredient not more than 45.0 mol % by Al₂O₃ conversion.

Item 569. The thin film substrate as described in Item 568, wherein the sintered compact which comprises a zinc oxide as the main ingredients contains an aluminum ingredient in the range of 0.001 mol %-45.0 mol % by Al₂O₃ conversion.

Item 570. The thin film substrate as described in Item 568 or 569, wherein the sintered compact which comprises a zinc oxide as the main ingredients contains an aluminum ingredient in the range of 0.005 mol %-45.0 mol % by Al₂O₃ conversion.

Item 571. The thin film substrate as described in Item 568, 569, or 570, wherein the sintered compact which comprises a zinc oxide as the main ingredients contains an aluminum ingredient in the range of 0.02 mol %-45.0 mol % by Al₂O₃ conversion.

Item 572. The thin film substrate as described in Item 568, 569, 570, or 571, wherein the sintered compact which comprises a zinc oxide as the main ingredients contains an aluminum ingredient in the range of 0.08 mol %-35.0 mol % by Al₂O₃ conversion.

Item 573. The thin film substrate as described in Item 550, 551, 552, 553, 554, 555, 556, 557, 558, 559, 560, 561, 562, 563, 564, 565, 566, 567, 568, 569, 570, 571, or 572, wherein the sintered compact which comprises a zinc oxide as the main ingredients contains at least one or more ingredients selected from an alkaline-earth-metals ingredient, a rare earth element ingredient, a transition metal ingredient, and a silicon ingredient.

Item 574. The thin film substrate as described in Item 573, wherein the sintered compact which comprises a zinc oxide as the main ingredients contains at least one or more ingredients selected from a rare earth element ingredient and a transition metal ingredient.

Item 575. The thin film substrate as described in Item 573 or 574, wherein the sintered compact which comprises a zinc oxide as the main ingredients contains at least one or more ingredients selected from a rare earth element ingredient.

Item 576. The thin film substrate as described in Item 575, wherein the sintered compact which comprises a zinc oxide as the main ingredients contains at least one or more ingredients selected from a rare earth element ingredient and has optical permeability.

Item 577. The thin film substrate as described in Item 575 or 576, wherein the sintered compact which comprises a zinc oxide as the main ingredients contains at least one or more ingredients selected from a rare earth element ingredient and has the optical transmissivity not less than 30%.

Item 578. The thin film substrate as described in Item 552, 553, 554, 555, 556, 557, 558, 559, 560, 561, 562, 563, 564, 565, 566, 567, 568, 569, 570, 571, 572, 573, 574, 575, 576, or 577, wherein the optical permeability or optical transmissivity is a thing in the light of the range of 200nm-800nm wavelength at least.

Item 579. The thin film substrate which was described in Item 573 or 574, wherein the sintered compact which comprises a zinc oxide as the main ingredients contains at least one or more ingredients selected from a transition metal ingredient.

Item 580. The thin film substrate as described in Item 573, 574, 575, 576, 577, 578, or 579, wherein the sintered compact which comprises a zinc oxide as the main ingredients contains at least one or more ingredients selected from a rare earth element ingredient and a transition metal ingredient not more than 10.0 mol % by oxide conversion.

Item 581 The thin film substrate as described in Item 573, 574, 579, or 580, wherein the transition metal ingredient is at least one or more ingredients selected from iron and chromium.

Item 582. The thin film substrate as described in Item 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, or 581, wherein the sintered compact which comprises a zinc oxide as the main ingredients contains an aluminum ingredient and contains simultaneously at least one or more ingredients selected from a rare earth element ingredient and a transition metal ingredient.

Item 583. The thin film substrate as described in Item 582, wherein the sintered compact which comprises a zinc oxide as the main ingredients contains an aluminum ingredient and contains simultaneously at least one or more ingredients selected from a rare earth element ingredient.

Item 584. The thin film substrate as described in Item 582, wherein the sintered compact which comprises a zinc oxide as the main ingredients contains an aluminum ingredient and contains simultaneously at least one or more ingredients selected from a transition metal ingredient.

Item 585. The thin film substrate as described in Item 582 or 584, wherein the transition metal ingredient is at least one or more ingredients selected from iron and chromium.

Item 586. The thin film substrate as described in Item 582, 583, 584, or 585, wherein the sintered compact which comprises a zinc oxide as the main ingredients contains at least one or more ingredients selected from a rare earth element ingredient and a transition metal ingredient not more than 10.0 mol % by oxide conversion.

Item 587. The thin film substrate as described in Item 586, wherein the sintered compact which comprises a zinc oxide as the main ingredients contains at least one or more ingredients selected from a rare earth element ingredient not more than 10.0 mol % by oxide conversion.

Item 588. The thin film substrate as described in Item 586 or 587, wherein the sintered compact which comprises a zinc oxide as the main ingredients contains at least one or more ingredients selected from a transition metal ingredient not more than 10.0 mol % by oxide conversion.

Item 589. The thin film substrate as described in Item 582, 583, 584, or 585, wherein the sintered compact which comprises a zinc oxide as the main ingredients contains an aluminum ingredient not more than 45.0 mol % by Al₂O₃ conversion and contains simultaneously at least one or more ingredients selected from a rare earth element ingredient not more than 10.0 mol % by oxide conversion.

Item 590. The thin film substrate as described in Item 589, wherein the sintered compact which comprises a zinc oxide as the main ingredients contains an aluminum ingredient not more than 45.0 mol % by Al₂O₃ conversion and contains simultaneously at least one or more ingredients selected from a rare earth element ingredient in the range of 0.0002 mol %-10.0 mol % by oxide conversion.

Item 591. The thin film substrate as described in Item 589 or 590, wherein the sintered compact which comprises a zinc oxide as the main ingredients contains an aluminum ingredient not more than 45.0 mol % by Al₂O₃ conversion and contains simultaneously at least one or more ingredients selected from a rare earth element ingredient in the range of 0.0006 mol %-6.0 mol % by oxide conversion.

Item 592. The thin film substrate as described in Item 589, 590, or 591, wherein the sintered compact which comprises a zinc oxide as the main ingredients contains an aluminum ingredient not more than 45.0 mol % by Al₂O₃ conversion and contains simultaneously at least one or more ingredients selected from a rare earth element ingredient in the range of 0.001 mol %-6.0 mol % by oxide conversion.

Item 593. The thin film substrate as described in Item 589, 590, 591, or 592, wherein the sintered compact which comprises a zinc oxide as the main ingredients contains an aluminum ingredient not more than 45.0 mol % by Al₂O₃ conversion and contains simultaneously at least one or more ingredients selected from a rare earth element ingredient in the range of 0.002 mol %-3.0 mol % by oxide conversion.

Item 594. The thin film substrate as described in Item 582, 583, 584, 585, 586, 587, 588, 589, 590, 591, 592, or 593, wherein the sintered compact which comprises a zinc oxide as the main ingredients contains the aluminum ingredient in the range of 0.001 mol %-45.0 mol % by Al₂O₃ conversion and contains simultaneously at least one or more ingredients selected from a rare earth element ingredient.

Item 595. The thin film substrate in which a thin film which comprises as the main ingredients at least one or more materials selected from a gallium nitride, an indium nitride, and an aluminum nitride is formed on the substrate consisting of a sintered compact comprising a ceramic material having at least one of the crystal structures selected from a hexagonal system or a trigonal system as the main ingredients and was described in Item 548, 549, or 550, and the sintered compact comprising a ceramic material having at least one of the crystal structures selected from a hexagonal system or a trigonal system as the main ingredients is a sintered compact which comprises a beryllium oxide as the main ingredients.

Item 596. The thin film substrate as described in Item 550 or 595, wherein the sintered compact which comprises as the main ingredients a beryllium oxide has optical permeability.

Item 597. The thin film substrate as described in Item 550, 595, or 596, wherein the sintered compact which comprises a beryllium oxide as the main ingredients has the optical transmissivity not less than 1%.

Item 598. The thin film substrate as described in Item 597, wherein the sintered compact which comprises a beryllium oxide as the main ingredients has the optical transmissivity not less than 10%.

Item 599. The thin film substrate as described in Item 597 or 598, wherein the sintered compact which comprises a beryllium oxide as the main ingredients has the optical transmissivity not less than 20%.

Item 600. The thin film substrate as described in Item 597, 598, or 599, wherein the sintered compact which comprises a beryllium oxide as the main ingredients has the optical transmissivity not less than 30%.

Item 601. The thin film substrate as described in Item 597, 598, 599, or 600, wherein the sintered compact which comprises a beryllium oxide as the main ingredients has the optical transmissivity not less than 40%.

Item 602. The thin film substrate as described in Item 597, 598, 599, 600, or 601, wherein the sintered compact which comprises a beryllium oxide as the main ingredients has the optical transmissivity not less than 50%.

Item 603. The thin film substrate as described in Item 597, 598, 599, 600, 601, or 602, wherein the sintered compact which comprises a beryllium oxide as the main ingredients has the optical transmissivity not less than 60%.

Item 604. The thin film substrate as described in Item 597, 598, 599, 600, 601, 602, or 603, wherein the sintered compact which comprises a beryllium oxide as the main ingredients has the optical transmissivity not less than 80%.

Item 605. The thin film substrate in which a thin film which comprises as the main ingredients at least one or more materials selected from a gallium nitride, an indium nitride, and an aluminum nitride is formed on the substrate consisting of a sintered compact comprising a beryllium oxide as the main ingredients and was described in Item 550 or 595, and the optical transmissivity of the sintered compact which comprises a beryllium oxide as the main ingredients is smaller than 1%.

Item 606. The thin film substrate as described in Item 605, wherein the sintered compact which comprises a beryllium oxide as the main ingredients is the optical transmissivity of 0%.

Item 607. The thin film substrate as described in Item 596, 597, 598, 599, 600, 601, 602, 603, 604, 605, or 606, wherein the optical permeability or optical transmissivity is a thing in the light of the range of 200nm-800nm wavelength at least.

Item 608. The thin film substrate as described in Item 550, 595, 596, 597, 598, 599, 600, 601, 602, 603, 604, 605, 606, or 607, wherein the sintered compact which comprises a beryllium oxide as the main ingredients contains at least one or more ingredients selected from a magnesium ingredient, a calcium ingredient, and a silicon ingredient.

Item 609. The thin film substrate as described in Item 550, 595, 596, 597, 598, 599, 600, 601, 602, 603, 604, 605, 606, 607, or 608, wherein the sintered compact which comprises a beryllium oxide as the main ingredients contains a beryllium oxide ingredient not less than 65.0 mol % by BeO conversion.

Item 610. The thin film substrate as described in Item 550, 595, 596, 597, 598, 599, 600, 601, 602, 603, 604, 605, 606, 607, 608, or 609, wherein the sintered compact which comprises a beryllium oxide as the main ingredients contains at least one or more ingredients selected from a magnesium ingredient, a calcium ingredient, and a silicon ingredient a total of not more than 35.0 mol % by oxide conversion.

Item 611. The thin film substrate as described in Item 610, wherein the sintered compact which comprises a beryllium oxide as the main ingredients contains at least one or more ingredients selected from a magnesium ingredient, a calcium ingredient, and a silicon ingredient in the range of 0.0002 mol %-35.0 mol % in total by oxide conversion.

Item 612. The thin film substrate as described in Item 610 or 611, wherein the sintered compact which comprises a beryllium oxide as the main ingredients contains at least one or more ingredients selected from a magnesium ingredient, a calcium ingredient, and a silicon ingredient in the range of 0.001 mol %-35.0 mol % in total by oxide conversion.

Item 613. The thin film substrate as described in Item 610, 611, or 612, wherein the sintered compact which comprises a beryllium oxide as the main ingredients contains at least one or more ingredients selected from a magnesium ingredient, a calcium ingredient, and a silicon ingredient in the range of 0.004 mol %-35.0 mol % in total by oxide conversion.

Item 614. The thin film substrate as described in Item 610, 611, 612, or 613, wherein the sintered compact which comprises a beryllium oxide as the main ingredients contains at least one or more ingredients selected from a magnesium ingredient, a calcium ingredient, and a silicon ingredient in the range of 0.015 mol %-25.0 mol % in total by oxide conversion.

Item 615. The thin film substrate as described in Item 550, 595, 596, 597, 598, 599, 600, 601, 602, 603, 604, 605, 606, 607, 608, 609, 610, 611, 612, 613, or 614, wherein the sintered compact which comprises a beryllium oxide as the main ingredients contains at least one or more ingredients selected from a magnesium ingredient, a calcium ingredient, and a silicon ingredient and contains simultaneously at least one or more ingredients selected from a rare earth element ingredient.

Item 616. The thin film substrate as described in Item 615, wherein the sintered compact which comprises a beryllium oxide as the main ingredients contains at least one or more ingredients selected from a magnesium ingredient, a calcium ingredient, and a silicon ingredient and contains simultaneously at least one or more ingredients selected from a rare earth element ingredient not more than 5.0 mol % by oxide conversion.

Item 617. The thin film substrate as described in Item 615 or 616, wherein the sintered compact which comprises a beryllium oxide as the main ingredients contains at least one or more ingredients selected from a magnesium ingredient, a calcium ingredient, and a silicon ingredient not more than 35.0 mol % by oxide conversion and contains simultaneously at least one or more ingredients selected from a rare earth element ingredient not more than 5.0 mol % by oxide conversion.

Item 618. The thin film substrate as described in Item 615, 616, or 617, wherein the sintered compact which comprises a beryllium oxide as the main ingredients contains at least one or more ingredients selected from a magnesium ingredient, a calcium ingredient, and a silicon ingredient not more than 35.0 mol % by oxide conversion and contains simultaneously at least one or more ingredients selected from a rare earth element ingredient in the range of 0.00005 mol %-5.0 mol % by oxide conversion.

Item 619. The thin film substrate as described in Item 615, 616, 617, or 618, wherein the sintered compact which comprises a beryllium oxide as the main ingredients contains at least one or more ingredients selected from a magnesium ingredient, a calcium ingredient, and a silicon ingredient not more than 35.0 mol % by oxide conversion and contains simultaneously at least one or more ingredients selected from a rare earth element ingredient in the range of 0.0005 mol %-3.0 mol % by oxide conversion.

Item 620. The thin film substrate as described in Item 615, 616, 617, 618, or 619, wherein the sintered compact which comprises a beryllium oxide as the main ingredients contains at least one or more ingredients selected from a magnesium ingredient, a calcium ingredient, and a silicon ingredient not more than 35.0 mol % by oxide conversion and contains simultaneously at least one or more ingredients selected from a rare earth element ingredient in the range of 0.002 mol %-3.0 mol % by oxide conversion.

Item 621. The thin film substrate as described in Item 615, 616, 617, 618, 619, or 620, wherein the sintered compact which comprises a beryllium oxide as the main ingredients contains at least one or more ingredients selected from a magnesium ingredient, a calcium ingredient, and a silicon ingredient not more than 35.0 mol % by oxide conversion and contains simultaneously at least one or more ingredients selected from a rare earth element ingredient in the range of 0.005 mol %-3.0 mol % by oxide conversion.

Item 622. The thin film substrate as described in Item 615, 616, 617, 618, 619, 620, or 621, wherein the sintered compact which comprises a beryllium oxide as the main ingredients contains at least one or more ingredients selected from a magnesium ingredient, a calcium ingredient, and a silicon ingredient in the range of 0.0002 mol %-35.0 mol % by oxide conversion and contains simultaneously at least one or more ingredients selected from a rare earth element ingredient.

Item 623. The thin film substrate in which a thin film which comprises as the main ingredients at least one or more materials selected from a gallium nitride, an indium nitride, and an aluminum nitride is formed on the substrate consisting of a sintered compact comprising a ceramic material having at least one of the crystal structures selected from a hexagonal system or a trigonal system as the main ingredients and was described in Item 548, 549, or 550, and the sintered compact comprising a ceramic material having at least one of the crystal structures selected from a hexagonal system or a trigonal system as the main ingredients is a sintered compact which comprises an aluminum oxide as the main ingredients.

Item 624. The thin film substrate as described in Item 550 or 623, wherein the sintered compact which comprises an aluminum oxide as the main ingredients has optical permeability.

Item 625. The thin film substrate as described in Item 550, 623, or 624, wherein the sintered compact which comprises an aluminum oxide as the main ingredients has the optical transmissivity not less than 1%.

Item 626. The thin film substrate as described in Item 625, wherein the sintered compact which comprises an aluminum oxide as the main ingredients has the optical transmissivity not less than 10%.

Item 627. The thin film substrate as described in Item 625 or 626, wherein the sintered compact which comprises an aluminum oxide as the main ingredients has the optical transmissivity not less than 20%.

Item 628. The thin film substrate as described in Item 625, 626, or 627, wherein the sintered compact which comprises an aluminum oxide as the main ingredients has the optical transmissivity not less than 30%.

Item 629. The thin film substrate as described in Item 625, 626, 627, or 628, wherein the sintered compact which comprises an aluminum oxide as the main ingredients has the optical transmissivity not less than 40%.

Item 630. The thin film substrate as described in Item 625, 626, 627, 628, or 629, wherein the sintered compact which comprises an aluminum oxide as the main ingredients has the optical transmissivity not less than 50%.

Item 631. The thin film substrate as described in Item 625, 626, 627, 628, 629, or 630, wherein the sintered compact which comprises an aluminum oxide as the main ingredients has the optical transmissivity not less than 60%.

Item 632. The thin film substrate as described in Item 625, 626, 627, 628, 629, 630, or 631, wherein the sintered compact which comprises an aluminum oxide as the main ingredients has the optical transmissivity not less than 80%.

Item 633. The thin film substrate in which a thin film which comprises as the main ingredients at least one or more materials selected from a gallium nitride, an indium nitride, and an aluminum nitride is formed on the substrate consisting of a sintered compact comprising an aluminum oxide as the main ingredients and was described in Item 550 or 623, and the optical transmissivity of this sintered compact which comprises an aluminum oxide as the main ingredients is smaller than 1%.

Item 634. The thin film substrate as described in Item 633, wherein the sintered compact which comprises a aluminum oxide as the main ingredients is the optical transmissivity of 0%.

Item 635. The thin film substrate as described in Item 624, 625, 626, 627, 628, 629, 630, 631, 632, 633, or 634, wherein the optical permeability or optical transmissivity is a thing in the light of the range of 200nm-800nm wavelength at least.

Item 636. The thin film substrate as described in Item 550, 623, 624, 625, 626, 627, 628, 629, 630, 631, 632, 633, 634, or 635, wherein the sintered compact which comprises an aluminum oxide as the main ingredients contains at least one or more ingredients selected from a magnesium ingredient, a calcium ingredient, and a silicon ingredient.

Item 637. The thin film substrate as described in Item 550, 623, 624, 625, 626, 627, 628, 629, 630, 631, 632, 633, 634, 635, or 636, wherein the sintered compact which comprises an aluminum oxide as the main ingredients contains an aluminum oxide ingredient not less than 55.0 mol % by Al₂O₃ conversion.

Item 638. The thin film substrate as described in Item 550, 623, 624, 625, 626, 627, 628, 629, 630, 631, 632, 633, 634, 635, 636, or 637, wherein the sintered compact which comprises an aluminum oxide as the main ingredients contains at least one or more ingredients selected from a magnesium ingredient, a calcium ingredient, and a silicon ingredient a total of not more than 45.0 mol % by oxide conversion.

Item 639. The thin film substrate as described in Item 638, wherein the sintered compact which comprises an aluminum oxide as the main ingredients contains at least one or more ingredients selected from a magnesium ingredient, a calcium ingredient, and a silicon ingredient in the range of 0.001 mol %-45.0 mol % in total by oxide conversion.

Item 640. The thin film substrate as described in Item 638 or 639, wherein the sintered compact which comprises an aluminum oxide as the main ingredients contains at least one or more ingredients selected from a magnesium ingredient, a calcium ingredient, and a silicon ingredient in the range of 0.005 mol %-45.0 mol % in total by oxide conversion.

Item 641. The thin film substrate as described in Item 638, 639, or 640, wherein the sintered compact which comprises an aluminum oxide as the main ingredients contains at least one or more ingredients selected from a magnesium ingredient, a calcium ingredient, and a silicon ingredient in the range of 0.02 mol %-45.0 mol % in total by oxide conversion.

Item 642. The thin film substrate as described in Item 638, 639, 640, or 641, wherein the sintered compact which comprises an aluminum oxide as the main ingredients contains at least one or more ingredients selected from a magnesium ingredient, a calcium ingredient, and a silicon ingredient in the range of 0.08 mol %-35.0 mol % in total by oxide conversion.

Item 643. The thin film substrate as described in Item 550, 623, 624, 625, 626, 627, 628, 629, 630, 631, 632, 633, 634, 635, 636, 637, 638, 639, 640, 641, or 642, wherein the sintered compact which comprises an aluminum oxide as the main ingredients contains at least one or more ingredients selected from a magnesium ingredient, a calcium ingredient, and a silicon ingredient and contains simultaneously at least one or more ingredients selected from a rare earth element ingredient.

Item 644. The thin film substrate as described in Item 643, wherein the sintered compact which comprises an aluminum oxide as the main ingredients contains at least one or more ingredients selected from a magnesium ingredient, a calcium ingredient, and a silicon ingredient and contains simultaneously at least one or more ingredients selected from a rare earth element ingredient not more than 10.0 mol % by oxide conversion.

Item 645. The thin film substrate as described in Item 643 or 644, wherein the sintered compact which comprises an aluminum oxide as the main ingredients contains at least one or more ingredients selected from a magnesium ingredient, a calcium ingredient, and a silicon ingredient not more than 45.0 mol % by oxide conversion and contains simultaneously at least one or more ingredients selected from a rare earth element ingredient not more than 10.0 mol % by oxide conversion.

Item 646. The thin film substrate as described in Item 643, 644, or 645, wherein the sintered compact which comprises an aluminum oxide as the main ingredients contains at least one or more ingredients selected from a magnesium ingredient, a calcium ingredient, and a silicon ingredient not more than 45.0 mol % by oxide conversion and contains simultaneously at least one or more ingredients selected from a rare earth element ingredient in the range of 0.0002 mol %-10.0 mol % by oxide conversion.

Item 647. The thin film substrate as described in Item 643, 644, 645, or 646, wherein the sintered compact which comprises an aluminum oxide as the main ingredients contains at least one or more ingredients selected from a magnesium ingredient, a calcium ingredient, and a silicon ingredient not more than 45.0 mol % by oxide conversion and contains simultaneously at least one or more ingredients selected from a rare earth element ingredient in the range of 0.001 mol %-6.0 mol % by oxide conversion.

Item 648. The thin film substrate as described in Item 643, 644, 645, 646, or 647, wherein the sintered compact which comprises an aluminum oxide as the main ingredients contains at least one or more ingredients selected from a magnesium ingredient, a calcium ingredient, and a silicon ingredient not more than 45.0 mol % by oxide conversion and contains simultaneously at least one or more ingredients selected from a rare earth element ingredient in the range of 0.005 mol %-6.0 mol % by oxide conversion.

Item 649. The thin film substrate as described in Item 643, 644, 645, 646, 647, or 648, wherein the sintered compact which comprises an aluminum oxide as the main ingredients contains at least one or more ingredients selected from a magnesium ingredient, a calcium ingredient, and a silicon ingredient not more than 45.0 mol % by oxide conversion and contains simultaneously at least one or more ingredients selected from a rare earth element ingredient in the range of 0.01 mol %-6.0 mol % by oxide conversion.

Item 650. The thin film substrate as described in Item 643, 644, 645, 646, 647, 648, or 649, wherein the sintered compact which comprises an aluminum oxide as the main ingredients contains at least one or more ingredients selected from a magnesium ingredient, a calcium ingredient, and a silicon ingredient in the range of 0.001 mol %-45.0 mol % by oxide conversion and contains simultaneously at least one or more ingredients selected from a rare earth element ingredient.

Item 651. The thin film substrate as described in Item 550, 623, 624, 625, 626, 627, 628, 629, 630, 631, 632, 633, 634, 635, 636, 637, 638, 639, 640, 641, 642, 643, 644, 645, 646, 647, 648, 649, or 650, wherein the sintered compact which comprises an aluminum oxide as the main ingredients contains at least two or more ingredients selected from a magnesium ingredient, a calcium ingredient, and a silicon ingredient.

Item 652. The thin film substrate in which a thin film which comprises as the main ingredients at least one or more materials selected from a gallium nitride, an indium nitride, and an aluminum nitride is formed on the substrate consisting of a sintered compact comprising a ceramic material having at least one of the crystal structures selected from a hexagonal system or a trigonal system as the main ingredients and was described in Item 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601,602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, or 651, and the surface of the sintered compact comprising a ceramic material having at least one of the crystal structures selected from a hexagonal system or a trigonal system as the main ingredients is a smooth nature not more than 1000 nm as average surface roughness Ra.

Item 653. The thin film substrate as described in Item 652, wherein the surface of the sintered compact which comprises as the main ingredients a ceramic material which has at least one of the crystal structures selected from a hexagonal system or a trigonal system is a smooth nature not more than 100 nm as average surface roughness Ra.

Item 654. The thin film substrate as described in Item 652 or 653, wherein the surface of the sintered compact which comprises as the main ingredients a ceramic material which has at least one of the crystal structures selected from a hexagonal system or a trigonal system is a smooth nature not more than 30 nm as average surface roughness Ra.

Item 655. The thin film substrate as described in Item 652, 653, or 654, wherein the surface of the sintered compact which comprises as the main ingredients a ceramic material which has at least one of the crystal structures selected from a hexagonal system or a trigonal system is a smooth nature not more than 10 nm as average surface roughness Ra.

Item 656. The thin film substrate as described in Item 652, 653, 654, or 655, wherein the surface of the sintered compact which comprises as the main ingredients a ceramic material which has at least one of the crystal structures selected from a hexagonal system or a trigonal system is a smooth nature not more than 5 nm as average surface roughness Ra.

Item 657. The thin film substrate in which a thin film which comprises as the main ingredients at least one or more materials selected from a gallium nitride, an indium nitride, and an aluminum nitride is formed on the substrate consisting of a sintered compact comprising a ceramic material having at least one of the crystal structures selected from a hexagonal system or a trigonal system as the main ingredients and was described in Item 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, or 651, and the surface of the sintered compact comprising a ceramic material having at least one of the crystal structures selected from a hexagonal system or a trigonal system as the main ingredients is a smooth nature of more than 1000 nm as average surface roughness Ra.

Item 658. The thin film substrate as described in Item 652, 653, 654, 655, 656, or 657, wherein the surface of the sintered compact which comprises as the main ingredients a ceramic material which has at least one of the crystal structures selected from a hexagonal system or a trigonal system is in at least one of the states selected from the as-fired one (as-fire), lap polish or specular surface polish.

Item 659. The thin film substrate as described in Item 652, 653, 654, 655, 656, or 658, wherein the surface of the sintered compact which comprises as the main ingredients a ceramic material which has at least one of the crystal structures selected from a hexagonal system or a trigonal system is in the state where specular surface polish was carried out.

Item 660. A thin film substrate in which the thin film which comprises as the main ingredients at least one or more materials selected from a gallium nitride, an indium nitride, and an aluminum nitride, and is formed on the sintered compact which comprises a ceramic material as the main ingredients and which has optical permeability.

Item 661. The thin film substrate as described in Item 660, wherein the sintered compact which comprises a ceramic material as the main ingredients and which has optical permeability is substrate-like.

Item 662. The thin film substrate as described in Item 660 or 661, wherein the ceramic material is at least one or more materials selected from a zirconium dioxide, a magnesium oxide, a magnesium aluminate, a titanium oxide, a barium titanate, a lead titanate zirconate, rare earth element oxides, a thorium dioxide, various ferrites, a mullite, a forsterite, a steatite, and glass ceramics.

Item 663. The thin film substrate as described in Item 660, 661, or 662, wherein the ceramic material is at least one or more materials selected from a zirconium dioxide, a magnesium oxide, a magnesium aluminate, rare earth element oxides, a thorium dioxide, a mullite, and glass ceramics.

Item 664. The thin film substrate as described in Item 660, 661, 662, or 663, wherein the ceramic material is at least one or more materials selected from a zirconium dioxide, a magnesium oxide, a magnesium aluminate, a yttrium oxides.

Item 665. The thin film substrate as described in Item 660, 661, 662, 663, or 664, wherein the sintered compact which comprises a ceramic material as the main ingredients is the optical transmissivity not less than 1%.

Item 666. The thin film substrate as described in Item 665, wherein the sintered compact which comprises a ceramic material as the main ingredients is the optical transmissivity not less than 10%.

Item 667. The thin film substrate as described in Item 665 or 666, wherein the sintered compact which comprises a ceramic material as the main ingredients is the optical transmissivity not less than 20%.

Item 668. The thin film substrate as described in Item 665, 666, or 667, wherein the sintered compact which comprises a ceramic material as the main ingredients is the optical transmissivity not less than 30%.

Item 669. The thin film substrate as described in Item 665, 666, 667, or 668, wherein the sintered compact which comprises a ceramic material as the main ingredients is the optical transmissivity not less than 40%.

Item 670. The thin film substrate as described in Item 665, 666, 667, 668, or 669, wherein the sintered compact which comprises a ceramic material as the main ingredients is the optical transmissivity not less than 40%.

Item 671. The thin film substrate as described in Item 665, 666, 667, 668, 669, or 670, wherein the sintered compact which comprises a ceramic material as the main ingredients is the optical transmissivity not less than 50%.

Item 672. The thin film substrate as described in Item 665, 666, 667, 668, 669, 670, or 671, wherein the sintered compact which comprises a ceramic material as the main ingredients is the optical transmissivity not less than 60%.

Item 673. The thin film substrate as described in Item 665, 666, 667, 668, 669, 670, 671, or 672, wherein the sintered compact which comprises a ceramic material as the main ingredients is the optical transmissivity not less than 80%.

Item 674. The thin film substrate as described in Item 660, 661, 662, 663, or 664, wherein the optical transmissivity of the sintered compact which comprises a ceramic material as the main ingredients is smaller than 1%.

Item 675. The thin film substrate as described in Item 674, wherein the optical transmissivity of the sintered compact which comprises a ceramic material as the main ingredients is 0%.

Item 676. The thin film substrate as described in Item 660, 661, 662, 663, 664, 665, 666, 667, 668, 669, 670, 671, 672, 673, 674, or 675, wherein the optical permeability or optical transmissivity is a thing in the light of the range of 200nm-800nm wavelength at least.

Item 677. The thin film substrate in which a thin film which comprises as the main ingredients at least one or more materials selected from a gallium nitride, an indium nitride, and an aluminum nitride is formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, and was described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, or 676, and the thin film which comprises as the main ingredients at least one or more materials selected from a gallium nitride, an indium nitride, and an aluminum nitride has at least one of the crystallized states selected from a single crystal, an amorphous state, a polycrystal, and an orientated polycrystal.

Item 678. The thin film substrate as described in Item 677, wherein at least a part of the thin film which comprises as the main ingredients at least one or more materials selected from a gallium nitride, an indium nitride, and an aluminum nitride is a single crystal.

Item 679. The thin film substrate as described in Item 677 or 678, wherein at least a part of the thin film which comprises as the main ingredients at least one or more materials selected from a gallium nitride, an indium nitride, and an aluminum nitride is a single crystal and has further at least one of the crystallized states selected from an amorphous state, a polycrystal, and an orientated polycrystal.

Item 680. The thin film substrate as described in Item 677, 678, or 679, wherein the thin film which comprises as the main ingredients at least one or more materials selected from a gallium nitride, an indium nitride, and an aluminum nitride consists only of a single crystal.

Item 681. The thin film substrate as described in Item 677, 678, or 679, wherein at least a part of the thin film which comprises as the main ingredients at least one or more materials selected from a gallium nitride, an indium nitride, and an aluminum nitride is amorphous.

Item 682. The thin film substrate as described in Item 681, wherein at least a part of the thin film which comprises as the main ingredients at least one or more materials selected from a gallium nitride, an indium nitride, and an aluminum nitride is amorphous and has further at least one of the crystallized states selected from a single crystal, a polycrystal, and an orientated polycrystal.

Item 683. The thin film substrate as described in Item 681, wherein the thin film is amorphous altogether.

Item 684. The thin film substrate as described in Item 677, 678, 679, 681, or 682, wherein at least a part of the thin film which comprises as the main ingredients at least one or more materials selected from a gallium nitride, an indium nitride, and an aluminum nitride is a polycrystal.

Item 685. The thin film substrate as described in Item 684, wherein at least a part of the thin film which comprises as the main ingredients at least one or more materials selected from a gallium nitride, an indium nitride, and an aluminum nitride is a polycrystal and has further at least one of the crystallized states selected from a single crystal, an amorphous state, and an orientated polycrystal.

Item 686. The thin film substrate as described in Item 684, wherein the thin film which comprises as the main ingredients at least one or more materials selected from a gallium nitride, an indium nitride, and an aluminum nitride is a polycrystal altogether.

Item 687. The thin film substrate as described in Item 677, 678, 679, 681, 682, 684, or 685, wherein at least a part of the thin film which comprises as the main ingredients at least one or more materials selected from a gallium nitride, an indium nitride, and an aluminum nitride is an orientated polycrystal.

Item 688. The thin film substrate as described in Item 687, wherein at least a part of the thin film which comprises as the main ingredients at least one or more materials selected from a gallium nitride, an indium nitride, and an aluminum nitride is an orientated polycrystal and has further at least one of the crystallized states selected from a single crystal, an amorphous state, and a polycrystal.

Item 689. The thin film substrate as described in Item 687, wherein the thin film which comprises as the main ingredients at least one or more materials selected from a gallium nitride, an indium nitride, and an aluminum nitride is an orientated polycrystal altogether.

Item 690. The thin film substrate as described in Item 677, 678, 679, 680, 681, 682, 684, 685, 687, or 688, wherein at least a part of the thin film which comprises as the main ingredients at least one or more materials selected from a gallium nitride, an indium nitride, and an aluminum nitride is a single crystal, and that the single crystal portion of this thin film is being formed directly on the sintered compact which comprises an aluminum nitride as the main ingredients.

Item 691. The thin film substrate as described in Item 677, 678, 679, 680, 681, 682, 684, 685, 687, or 688, wherein at least a part of the thin film which comprises as the main ingredients at least one or more materials selected from a gallium nitride, an indium nitride, and an aluminum nitride is a single crystal, and that the single crystal portion of this thin film is being formed directly on the sintered compact which comprises as the main ingredients a ceramic material which has at least one of the crystal structures selected from a hexagonal system or a trigonal system.

Item 692. The thin film substrate as described in Item 677, 678, 679, 681, 682, 683, 684, 685, 686, 687, 688, 689, or 690, wherein at least a part of the thin film which comprises as the main ingredients at least one or more materials selected from a gallium nitride, an indium nitride, and an aluminum nitride is at least one of the crystallized states selected from an amorphous state, a polycrystal, and an orientated polycrystal, and that what is at least one of the crystallized states selected from an amorphous state, a polycrystal, and an orientated polycrystal is directly formed on the sintered compact which comprises an aluminum nitride as the main ingredients.

Item 693. The thin film substrate as described in Item 677, 678, 679, 681, 682, 683, 684, 685, 686, 687, 688, 689, or 691, wherein at least a part of the thin film which comprises as the main ingredients at least one or more materials selected from a gallium nitride, an indium nitride, and an aluminum nitride is at least one of the crystallized states selected from an amorphous state, a polycrystal, and an orientated polycrystal, and that what is at least one of the crystallized states selected from an amorphous state, a polycrystal, and an orientated polycrystal is directly formed on the sintered compact which comprises as the main ingredients a ceramic material which has at least one of the crystal structures selected from a hexagonal system or a trigonal system.

Item 694. The thin film substrate as described in Item 677, 678, 679, 681, 682, 683, 684, 685, 686, 687, 688, or 689, wherein at least a part of the thin film which comprises as the main ingredients at least one or more materials selected from a gallium nitride, an indium nitride, and an aluminum nitride is at least one of the crystallized states selected from an amorphous state, a polycrystal, and an orientated polycrystal and that what is at least one of the crystallized states selected from an amorphous state, a polycrystal, and an orientated polycrystal is directly formed on the sintered compact which comprises a ceramic material as the main ingredients and which has optical permeability.

Item 695. The thin film substrate as described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, or 694, wherein the currently formed thin film which comprises as the main ingredients at least one or more materials selected from a gallium nitride, an indium nitride, and an aluminum nitride is a single layer.

Item 696. The thin film substrate as described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, or 694, wherein the currently formed thin film which comprises as the main ingredients at least one or more materials selected from a gallium nitride, an indium nitride, and an aluminum nitride is being constituted with at least two or more layers.

Item 697. The thin film substrate as described in Item 696, wherein among the thin film which is being constituted with at least two or more layers, at least two layers are either that whose composition differs respectively or that whose crystallized state differs respectively.

Item 698. The thin film substrate as described in Item 696 or 697, wherein among the thin film which is being constituted with at least two or more layers, at least two layers are different composition respectively.

Item 699. The thin film substrate as described in Item 696, 697, or 698, wherein among the thin film which is being constituted with at least two or more layers, at least two layers are different composition respectively and have same crystallized state.

Item 700. The thin film substrate as described in Item 696, 697, 698, or 699, wherein among the thin film which is being constituted with at least two or more layers, at least two layers are different composition respectively and different crystallized state.

Item 701. The thin film substrate as described in Item 696 or 697, wherein among the thin film which is being constituted with at least two or more layers, at least two layers are same composition.

Item 702. The thin film substrate as described in Item 696, 697, or 701, wherein among the thin film which is being constituted with at least two or more layers, at least two layers are same composition and different crystallized state respectively.

Item 703. The thin film substrate as described in Item 696, wherein among the thin film which is being constituted with at least two or more layers, at least two layers are same composition respectively and same crystallized state.

Item 704. The thin film substrate as described in Item 696, 697, 698, 699, 700, 701, 702, or 703, wherein each layer of the thin film which is being constituted with at least two or more layers has at least one of the crystallized states selected from a single crystal, an orientated polycrystal, a polycrystal, and an amorphous state respectively.

Item 705. The thin film substrate as described in Item 696, 697, 698, 699, 700, 701, 702, 703, or 704, wherein in the thin film which is being constituted with at least two or more layers, the thin film layer which is being formed directly on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability is what has at least one of the crystallized states selected from a single crystal, an orientated polycrystal, a polycrystal, and an amorphous state.

Item 706. The thin film substrate as described in Item 705, wherein in the thin film which is being constituted with at least two or more layers, the thin film layer which is being formed directly on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability is what has at least one of the crystallized states selected from an orientated polycrystal, a polycrystal, and an amorphous state.

Item 707. The thin film substrate as described in Item 705 or 706, wherein in the thin film which is being constituted with at least two or more layers, the thin film layer which is being formed directly on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability is an orientated polycrystal.

Item 708. The thin film substrate as described in Item 696, 697, 698, 699, 700, 701, 702, 703, 704, 705, 706, or 707, wherein in the thin film which is being constituted with at least two or more layers, at least one or more layers of a single crystal thin film which comprises as the main ingredients at least one or more materials selected from a gallium nitride, an indium nitride, and an aluminum nitride are formed furthermore on it, after at least one or more layers of the thin film which comprises as the main ingredients at least one or more materials selected from a gallium nitride, an indium nitride, and an aluminum nitride and which has at least one of the crystallized states selected from a single crystal, an orientated polycrystal, a polycrystal, and an amorphous state are formed on at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 709. The thin film substrate as described in Item 708, wherein in the thin film which is being constituted with at least two or more layers, at least one or more layers of a single crystal thin film which comprises as the main ingredients at least one or more materials selected from a gallium nitride, an indium nitride, and an aluminum nitride are formed furthermore on it, after at least one or more layers of the thin film which comprises as the main ingredients at least one or more materials selected from a gallium nitride, an indium nitride, and an aluminum nitride and which has at least one of the crystallized states selected from an orientated polycrystal, a polycrystal, and an amorphous are formed on at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 710. The thin film substrate as described in Item 708 or 709, wherein in the thin film which is being constituted with at least two or more layers, at least one or more layers of the single crystal thin film which comprises as the main ingredients at least one or more materials selected from a gallium nitride, an indium nitride, and an aluminum nitride are formed furthermore on it, after at least one or more layers of an amorphous thin film which comprises as the main ingredients at least one or more materials selected from a gallium nitride, an indium nitride, and an aluminum nitride are formed on at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 711. The thin film substrate as described in Item 708 or 709, wherein in the thin film which is being constituted with at least two or more layers, at least one or more layers of the single crystal thin film which comprises as the main ingredients at least one or more materials selected from a gallium nitride, an indium nitride, and an aluminum nitride are formed furthermore on it, after at least one or more layers of a polycrystalline thin film which comprises as the main ingredients at least one or more materials selected from a gallium nitride, an indium nitride, and an aluminum nitride are formed on at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 712. The thin film substrate as described in Item 708 or 709, wherein in the thin film which is being constituted with at least two or more layers, at least one or more layers of the single crystal thin film which comprises as the main ingredients at least one or more materials selected from a gallium nitride, an indium nitride, and an aluminum nitride are formed furthermore on it, after at least one or more layers of an orientated polycrystalline thin film which comprises as the main ingredients at least one or more materials selected from a gallium nitride, an indium nitride, and an aluminum nitride are formed on at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 713. The thin film substrate as described in Item 696, 697, 698, 699, 700, 701, 702, 703, 704, 705, 706, 707, 708, 709, 710, 711, or 712, wherein in the thin film which is being constituted with at least two or more layers, in the thin film of the constitution whose at least one or more layers of the single crystal thin film layer are being formed furthermore on the thin film layer which is being formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, the layer which consists of this single crystal are at least two or more layers.

Item 714. The thin film substrate as described in Item 696, 697, 698, 699, 700, 701, 702, 703, 704, 705, 706, 707, 708, 709, 710, 711, 712, or 713, wherein in the thin film which is being constituted with at least two or more layers, at least one or more layers of the thin film which comprises as the main ingredients at least one or more materials selected from a gallium nitride, an indium nitride, and an aluminum nitride and has at least one of the crystallized states selected from a single crystal, an orientated polycrystal, a polycrystal, and an amorphous state are formed furthermore on it, after at least one or more layers of the thin film which comprises as the main ingredients at least one or more materials selected from a gallium nitride, an indium nitride, and an aluminum nitride and has at least one of the crystallized states selected from a single crystal, an orientated polycrystal, a polycrystal, and an amorphous state are formed on at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 715. The thin film substrate as described in Item 696, 697, 698, 699, 700, 701, 702, 703, 704, 705, 706, 707, 708, 709, 710, 711, 712, 713, or 714 characterized in that in the thin film which is being constituted with at least two or more layers, at least one or more layers of the single crystal thin film which comprises as the main ingredients at least one or more materials selected from a gallium nitride, an indium nitride, and an aluminum nitride are formed furthermore on it, after at least one or more layers of the thin film which comprises as the main ingredients at least one or more materials selected from a gallium nitride, an indium nitride, and an aluminum nitride and has at least one of the crystallized states selected from a single crystal, an orientated polycrystal, a polycrystal, and an amorphous state are formed furthermore on it, after at least one or more layers of the thin film which comprises as the main ingredients at least one or more materials selected from a gallium nitride, an indium nitride, and an aluminum nitride and has at least one of the crystallized states selected from a single crystal, an orientated polycrystal, a polycrystal, and an amorphous state are formed on at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 716. The thin film substrate as described in Item 696, 697, 698, 699, 701, 703, 704, 705, 708, or 713, wherein in the thin film which is being constituted with at least two or more layers, all layers comprise only a single crystal.

Item 717. The thin film substrate as described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, or 716, wherein the single crystal thin film which comprises as the main ingredients at least one or more materials selected from a gallium nitride, an indium nitride, and an aluminum nitride is being formed on the surface of the substrate.

Item 718. The thin film substrate as described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, or 717, wherein the C axis of a single crystal thin film which comprises as the main ingredients at least one or more materials selected from a gallium nitride, an indium nitride, and an aluminum nitride is being formed in the perpendicular direction to the substrate surface.

Item 719. The thin film substrate as described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, or 717, wherein the C axis of a single crystal thin film which comprises as the main ingredients at least one or more materials selected from a gallium nitride, an indium nitride, and an aluminum nitride is being formed in the level direction to the substrate surface.

Item 720. The thin film substrate as described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, or 715, wherein the C axis of an orientated polycrystalline thin film which comprises as the main ingredients at least one or more materials selected from a gallium nitride, an indium nitride, and an aluminum nitride is being formed in the perpendicular direction to the substrate surface.

Item 721. The thin film substrate as described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, or 715, wherein the C axis of an orientated polycrystalline thin film which comprises as the main ingredients at least one or more materials selected from a gallium nitride, an indium nitride, and an aluminum nitride is being formed in the level direction to the substrate surface.

Item 722. The thin film substrate as described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, or 721, wherein the currently formed thin film which comprises as the main ingredients at least one or more materials selected from a gallium nitride, an indium nitride, and an aluminum nitride has electrical conductivity.

Item 723. The thin film substrate as described in Item 722, wherein the thin film which comprises as the main ingredients at least one or more materials selected from a gallium nitride, an indium nitride, and an aluminum nitride has electrical conductivity by being semiconductor-ized.

Item 724. The thin film substrate as described in Item 722 or 723, wherein the thin film which comprises as the main ingredients at least one or more materials selected from a gallium nitride, an indium nitride, and an aluminum nitride has electrical conductivity by at least one or more doping agents selected from magnesium, beryllium, calcium, zinc, cadmium, carbon, silicon, germanium, selenium, tellurium, and oxygen.

Item 725. The thin film substrate as described in Item 722, 723, or 724, wherein the thin film which comprises as the main ingredients at least one or more materials selected from a gallium nitride, an indium nitride, and an aluminum nitride has electrical conductivity by being semiconductor-ized into P type or N type.

Item 726. The thin film substrate as described in Item 696, 697, 698, 699, 700, 701, 702, 703, 704, 705, 706, 707, 708, 709, 710, 711, 712, 713, 714, 715, 716, 717, 718, 719, 720, 721, 722, 723, 724, or 725, wherein among the thin film which comprises as the main ingredients at least one or more materials selected from a gallium nitride, an indium nitride, and an aluminum nitride and is constituted with at least two or more layers, at least one layer has electrical conductivity.

Item 727. The thin film substrate as described in Item 722, 723, 724, 725, or 726, wherein the electric resistivity of the thin film which has electrical conductivity and comprises as the main ingredients at least one or more materials selected from a gallium nitride, an indium nitride, and an aluminum nitride is not more than 1×10⁴ Ω·cm in room temperature.

Item 728. The thin film substrate as described in Item 727, wherein the electric resistivity of the thin film which has electrical conductivity and comprises as the main ingredients at least one or more materials selected from a gallium nitride, an indium nitride, and an aluminum nitride is not more than 1×10² Ω·cm in room temperature.

Item 729. The thin film substrate as described in Item 727 or 728, wherein the electric resistivity of the thin film which has electrical conductivity and comprises as the main ingredients at least one or more materials selected from a gallium nitride, an indium nitride, and an aluminum nitride is not more than 1×10¹ Ω·cm in room temperature.

Item 730. The thin film substrate as described in Item 727, 728, or 729, wherein the electric resistivity of the thin film which has electrical conductivity and comprises as the main ingredients at least one or more materials selected from a gallium nitride, an indium nitride, and an aluminum nitride is not more than 1×10⁰ Ω·cm in room temperature.

Item 731. The thin film substrate as described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, or 730, wherein the thin film currently formed comprises as the main ingredients a composite expressed with the chemical formula of AlₓGa₁₋ₓN (0≦x≦1.0).

Item 732. The thin film substrate as described in Item 731, wherein the thin film currently formed comprises as the main ingredients a composite expressed with the chemical formula of AlₓGa₁₋ₓN (0≦x≦1.0) and contains a doping ingredient in the range of 0.00001-10 mol % to this composite.

Item 733. The thin film substrate as described in Item 731 or 732, wherein the thin film currently formed comprises as the main ingredients a composite expressed with the chemical formula of AlₓGa₁₋ₓN (0≦x≦0.6).

Item 734. The thin film substrate as described in Item 733, wherein the thin film currently formed comprises as the main ingredients a composite expressed with the chemical formula of AlₓGa₁₋ₓN (0≦x≦0.6) and contains a doping ingredient in the range of 0.00001-10 mol % to this composite,

Item 735. The thin film substrate as described in Item 731 or 732, wherein the thin film currently formed comprises as the main ingredients a composite expressed with the chemical formula of AlₓGa₁₋ₓN (0.6≦x≦1.0).

Item 736. The thin film substrate as described in Item 735, wherein the thin film currently formed comprises as the main ingredients a composite expressed with the chemical formula of AlₓGa₁₋ₓN (0.6≦x≦1.0) and contains a doping ingredient in the range of 0.00001-10 mol % to this composite.

Item 737. The thin film substrate as described in Item 731, 732, 733, 734, 735, or 736, wherein at least two or more doping ingredients are contained simultaneously.

Item 738. The thin film substrate as described in Item 732, 734, 736, or 737, wherein the doping ingredient is at least one or more elements selected from Mg, Be, Ca, Zn, Cd, C, Si, Ge, Se, Te, and O.

Item 739. The thin film substrate as described in Item 738, wherein the doping ingredient is at least one or more elements selected from Mg, Be, Zn, and Si.

Item 740. The thin film substrate as described in Item 731, 732, 733, 734, 737, 738, or 739, wherein the thin film currently formed comprises as the main ingredients a composite expressed with the chemical formula of AlₓGa₁₋ₓN (0≦x≦0.6) and contains at least one or more ingredients selected from Mg, Zn, and Si in the range of 0.00001-10 mol % to this composite.

Item 741. The thin film substrate as described in Item 740, wherein the thin film currently formed comprises as the main ingredients a composite expressed with the chemical formula of AlₓGa₁₋ₓN (0≦x≦0.6) and contains simultaneously at least two or more ingredients selected from Mg, Zn, and Si in the range of 0.00001-10 mol % in total to this composite.

Item 742. The thin film substrate as described in Item 731, 735, 736, 737, 738, or 739, wherein the thin film currently formed comprises as the main ingredients a composite expressed with the chemical formula of AlₓGa₁₋ₓN (0.6≦x≦1.0) and contains at least one or more ingredients selected from Mg, Zn, and Si in the range of 0.00001-10 mol % in total to this composite.

Item 743. The thin film substrate as described in Item 742, wherein the thin film currently formed comprises as the main ingredients a composite expressed with the chemical formula of AlₓGa₁₋ₓN (0.6≦x≦1.0) and contains simultaneously at least two or more ingredients selected from Mg, Zn, and Si in the range of 0.00001-10 mol % in total to this composite.

Item 744. The thin film substrate as described in Item 742 or 743, wherein the thin film currently formed comprises as the main ingredients a composite expressed with the chemical formula of AlₓGa₁₋ₓN (0.6≦x≦1.0) and contains Si in the range of 0.00001-0.5 mol % to this composite.

Item 745. The thin film substrate as described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, or 744, wherein the thin film currently formed on the substrate surface has a smooth nature not more than 20 nm as average surface roughness Ra.

Item 746. The thin film substrate as described in Item 719, wherein the thin film currently formed on the substrate surface has a smooth nature not more than 10 nm as average surface roughness Ra.

Item 747. The thin film substrate as described in Item 745 or 746, wherein the thin film currently formed on the substrate surface has a smooth nature not more than 5 nm as average surface roughness Ra.

Item 748. The thin film substrate as described in Item 745, 746, or 747, wherein the thin film currently formed on the substrate surface has a smooth nature not more than 3 nm as average surface roughness Ra.

Item 749. The thin film substrate as described in Item 745, 746, 747, or 748, wherein the thin film currently formed on the substrate surface has a smooth nature not more than 2 nm as average surface roughness Ra.

Item 750. The thin film substrate as described in Item 745, 746, 747, 748, or 749, wherein the thin film currently formed on the substrate surface has a smooth nature not more than 1 nm as average surface roughness Ra.

Item 751. The thin film substrate as described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, or 750, wherein the thickness of the thin film currently formed is not less than 0.5 nm.

Item 752. The thin film substrate as described in Item 751, wherein the thickness of the thin film currently formed is not less than 0.3 μm.

Item 753. The thin film substrate as described in Item 751 or 752, wherein the thickness of the thin film currently formed is not less than 3.5 μm.

Item 754. The thin film substrate as described in Item 751, 752, or 753, wherein the thickness of the thin film currently formed is not less than 10 μm.

Item 755. The thin film substrate as described in Item 751, 752, 753, or 754, wherein the thickness of the thin film currently formed is not less than 50 μm.

Item 756. The thin film substrate as described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, or 755, wherein the thickness of the thin film currently formed is not more than 1000 μm.

Item 757. The thin film substrate as described in Item 756, wherein the thickness of the thin film currently formed is not more than 500 μm.

Item 758. The thin film substrate as described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, or 757, wherein the currently formed single crystal thin film which comprises as the main ingredients at least one or more materials selected from a gallium nitride, an indium nitride, and an aluminum nitride has the crystallinity not more than 3600 seconds as half width of the rocking curve of the X ray diffraction line from the lattice plane of a Miller Index (002).

Item 759. The thin film substrate as described in Item 758, wherein the currently formed single crystal thin film which comprises as the main ingredients at least one or more materials selected from a gallium nitride, an indium nitride, and an aluminum nitride has the crystallinity not more than 300 seconds as half width of the rocking curve of the X ray diffraction line from the lattice plane of a Miller Index (002).

Item 760. The thin film substrate as described in Item 758 or 759, wherein the currently formed single crystal thin film which comprises as the main ingredients at least one or more materials selected from a gallium nitride, an indium nitride, and an aluminum nitride has the crystallinity not more than 240 seconds as half width of the rocking curve of the X ray diffraction line from the lattice plane of a Miller Index (002).

Item 761. The thin film substrate as described in Item 758, 759, or 760, wherein the currently formed single crystal thin film which comprises as the main ingredients at least one or more materials selected from a gallium nitride, an indium nitride, and an aluminum nitride has the crystallinity not more than 200 seconds as half width of the rocking curve of the X ray diffraction line from the lattice plane of a Miller Index (002).

Item 762. The thin film substrate as described in Item 758, 759, 760, or 761, wherein the currently formed single crystal thin film which comprises as the main ingredients at least one or more materials selected from a gallium nitride, an indium nitride, and an aluminum nitride has the crystallinity not more than 150 seconds as half width of the rocking curve of the X ray diffraction line from the lattice plane of a Miller Index (002).

Item 763. The thin film substrate as described in Item 758, 759, 70, 761, or 762, wherein the currently formed single crystal thin film which comprises as the main ingredients at least one or more materials selected from a gallium nitride, an indium nitride, and an aluminum nitride has the crystallinity not more than 130 seconds as half width of the rocking curve of the X ray diffraction line from the lattice plane of a Miller Index (002).

Item 764. The thin film substrate as described in Item 758, 759, 760, 761, 762, or 763, wherein the currently formed single crystal thin film which comprises as the main ingredients at least one or more materials selected from a gallium nitride, an indium nitride, and an aluminum nitride has the crystallinity not more than 100 seconds as half width of the rocking curve of the X ray diffraction line from the lattice plane of a Miller Index (002).

Item 765. The thin film substrate in which a thin film which comprises as the main ingredients at least one or more materials selected from a gallium nitride, an indium nitride, and an aluminum nitride is formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, and was described in Item 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 501, 502, 503, 504, 505, 506, 507, 508, 509, 510, 511, 512, 513, 514, 515, 516, 517, 518, 519, 520, 521, 522, 523, 524, 525, 526, 527, 528, 529, 530, 531, 532, 533, 534, 535, 536, 537, 538, 539, 540, 541, 542, 543, 544, 545, 546, 547, 548, 549, 550, 551, 552, 553, 554, 555, 556, 557, 558, 559, 560, 561, 562, 563, 564, 565, 566, 567, 568, 569, 570, 571, 572, 573, 574, 575, 576, 577, 578, 579, 580, 581, 582, 583, 584, 585, 586, 587, 588, 589, 590, 591, 592, 593, 594, 595, 596, 597, 598, 599, 600, 601, 602, 603, 604, 605, 606, 607, 608, 609, 610, 611, 612, 613, 614, 615, 616, 617, 618, 619, 620, 621, 622, 623, 624, 625, 626, 627, 628, 629, 630, 631, 632, 633, 634, 635, 636, 637, 638, 639, 640, 641, 642, 643, 644, 645, 646, 647, 648, 649, 650, 651, 652, 653, 654, 655, 656, 657, 658, 659, 660, 661, 662, 663, 664, 665, 666, 667, 668, 669, 670, 671, 672, 673, 674, 675, 676, 677, 678, 679, 680, 681, 682, 683, 684, 685, 686, 687, 688, 689, 690, 691, 692, 693, 694, 695, 696, 697, 698, 699, 700, 701, 702, 703, 704, 705, 706, 707, 708, 709, 710, 711, 712, 713, 714, 715, 716, 717, 718, 719, 720, 721, 722, 723, 724, 725, 726, 727, 728, 729, 730, 731, 732, 733, 734, 735, 736, 737, 738, 739, 740, 741, 742, 743, 744, 745, 746, 747, 748, 749, 750, 751, 752, 753, 754, 755, 756, 757, 758, 759, 760, 761, 762, 763, or 764, and the thin film substrate is used for forming a thin film which comprises as the main ingredients at least one or more materials selected from a gallium nitride, an indium nitride, and an aluminum nitride.

Item 766. The thin film substrate in which a thin film which comprises as the main ingredients at least one or more materials selected from a gallium nitride, an indium nitride, and an aluminum nitride is formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, and was described in Item 765, and the thin film is at least one of the crystallized states selected from a single crystal, an orientated polycrystal, a polycrystal, and an amorphous state.

Item 767. The thin film substrate in which a thin film which comprises as the main ingredients at least one or more materials selected from a gallium nitride, an indium nitride, and an aluminum nitride is formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, and was described in Item 765 or 766, and the thin film currently formed on the surface of a thin film substrate is a single crystal.

Item 768. The thin film substrate in which a thin film which comprises as the main ingredients at least one or more materials selected from a gallium nitride, an indium nitride, and an aluminum nitride is formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, and was described in Item 765 or 766, and the thin film currently formed on the surface of a thin film substrate is an orientated polycrystal.

Item 769. The thin film substrate in which a thin film which comprises as the main ingredients at least one or more materials selected from a gallium nitride, an indium nitride, and an aluminum nitride is formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, and was described in Item 765 or 766, and the thin film currently formed on the surface of a thin film substrate is a polycrystal.

Item 770. The thin film substrate in which a thin film which comprises as the main ingredients at least one or more materials selected from a gallium nitride, an indium nitride, and an aluminum nitride is formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, and was described in Item 765 or 766, and the thin film currently formed on the surface of a thin film substrate is amorphous.

Item 771. A thin film substrate in which an optical waveguide is formed on the sintered compact which comprises an aluminum nitride as the main ingredients by the thin film which comprises as the main ingredients at least one or more materials which are selected from a gallium nitride, an indium nitride, and an aluminum nitride.

Item 772. The thin film substrate as described in Item 771, wherein the optical waveguide consists of a thin film which comprises as the main ingredients at least one or more materials selected from a gallium nitride, an indium nitride, and an aluminum nitride and has at least one of the crystallized states selected from a single crystal, an amorphous state, a polycrystal, and an orientated polycrystal.

Item 773. The thin film substrate as described in Item 771 or 772, wherein the optical waveguide consists of a single crystal thin film which comprises as the main ingredients at least one or more materials selected from a gallium nitride, an indium nitride, and an aluminum nitride.

Item 774. The thin film substrate in which an optical waveguide is formed on the sintered compact comprising an aluminum nitride as the main ingredients by the single crystal thin film comprising at least one or more materials selected from a gallium nitride, an indium nitride, and an aluminum nitride as the main ingredients and was described in Item 773, and the optical waveguide consists of a single crystal thin film formed in the direction where C axis is perpendicular to the substrate surface.

Item 775. The thin film substrate in which an optical waveguide is formed on the sintered compact comprising an aluminum nitride as the main ingredients by the single crystal thin film comprising at least one or more materials selected from a gallium nitride, an indium nitride, and an aluminum nitride as the main ingredients and was described in Item 773, and the optical waveguide consists of a single crystal thin film formed in the direction where C axis is level to the substrate surface.

Item 776. The thin film substrate as described in Item 771, 772, 773, 774, or 775, wherein the optical waveguide comprises as the main ingredients at least one or more materials selected from a gallium nitride and an aluminum nitride.

Item 777. The thin film substrate as described in Item 771, 772, 773, 774, 775, or 776, wherein the optical waveguide comprises as the main ingredients a composite expressed with the chemical formula of AlₓGa₁₋ₓN (0.0≦x≦1.0).

Item 778. The thin film substrate as described in Item 777, wherein the optical waveguide comprises as the main ingredients a composite expressed with the chemical formula of AlₓGa₁₋ₓN (0.5≦x≦1.0).

Item 779. The thin film substrate as described in Item 777 or 778, wherein the optical waveguide comprises as the main ingredients a composite expressed with the chemical formula of AlₓGa₁₋ₓN (0.8≦x≦1.0).

Item 780. The thin film substrate as described in Item 777, 778, or 779, wherein the optical waveguide comprises as the main ingredients a composite expressed with the chemical formula of AlₓGa₁₋ₓN (0.9≦x≦1.0).

Item 781. The thin film substrate as described in Item 771, 772, 773, 774, 775, 776, 777, 778, 779, or 780, wherein the optical waveguide comprises an aluminum nitride as the main ingredients.

Item 782. The thin film substrate as described in Item 771, 772, 773, 774, 775, 776, 777, 778, 779, 780, or 781, wherein the optical waveguide consists of a thin film which comprises as the main ingredients at least one or more materials selected from a gallium nitride, an indium nitride, and an aluminum nitride and contains further at least one or more ingredients selected from gallium, indium, niobium, and tantalum.

Item 783. The thin film substrate as described in Item 782, wherein the optical waveguide consists of a thin film which comprises as the main ingredients at least one or more materials selected from a gallium nitride, an indium nitride, and an aluminum nitride and contains at least one or more ingredients selected from gallium, indium, niobium, and tantalum by thermal diffusion or ion implantation,

Item 784. The thin film substrate as described in Item 782 or 783, wherein the optical waveguide consists of a thin film which comprises as the main ingredients at least one or more materials selected from a gallium nitride, an indium nitride, and an aluminum nitride and contains further at least one or more ingredients selected from gallium, indium, niobium, and tantalum not more than 20 mol % to the main ingredients by nitride conversion.

Item 785. The thin film substrate as described in Item 771, 772, 773, 774, 775, 776, 777, 778, 779, 780, 781, 782, 783, or 784, wherein the optical waveguide consists of a thin film which comprises as the main ingredients at least one or more materials selected from a gallium nitride, an indium nitride, and an aluminum nitride and contains further at least one or more ingredients selected from niobium and tantalum.

Item 786. The thin film substrate as described in Item 785, wherein the content of at least one or more ingredients selected from niobium and tantalum is not more than 20 mol % to the main ingredients by nitride conversion.

Item 787. The thin film substrate as described in Item 782, 783, 784, 785, or 786, wherein the optical waveguide consists of a thin film which comprises as the main ingredients at least one or more materials selected from a gallium nitride and an aluminum nitride and contains further at least one or more ingredients selected from gallium, indium, niobium, and tantalum.

Item 788. The thin film substrate as described in Item 787, wherein the optical waveguide consists of a thin film which comprises as the main ingredients at least one or more materials selected from a gallium nitride and an aluminum nitride and contains further at least one or more ingredients selected from gallium, indium, niobium, and tantalum not more than 20 mol % by nitride conversion.

Item 789. The thin film substrate as described in Item 782, 783, 784, 785, 786, 787, or 788, wherein the optical waveguide consists of a thin film which comprises an aluminum nitride as the main ingredients and contains further at least one or more ingredients selected from gallium, indium, niobium, and tantalum.

Item 790. The thin film substrate as described in Item 789, wherein the optical waveguide consists of a thin film which comprises an aluminum nitride as the main ingredients and contains further at least one or more ingredients selected from gallium, indium, niobium, and tantalum not more than 20 mol % by nitride conversion.

Item 791. The thin film substrate in which an optical waveguide was formed on the sintered compact comprising an aluminum nitride as the main ingredients by the thin film comprising at least one or more materials selected from a gallium nitride, an indium nitride, and an aluminum nitride as the main ingredients and was described in Item 771, 772, 773, 774, 775, 776, 777, 778, 779, 780, 781, 782, 783, 784, 785, 786, 787, 788, 789, or 790, and the thin film substrate consists of the optical waveguide and the cladding layer whose refractive index is smaller than the optical waveguide.

Item 792. The thin film substrate as described in Item 791, wherein the cladding layer consists of a thin film which comprises as the main ingredients at least one or more materials selected from a gallium nitride, an indium nitride, and an aluminum nitride.

Item 793. The thin film substrate as described in Item 792, wherein the optical waveguide consists of a thin film which comprises as the main ingredients at least one or more materials selected from a gallium nitride, an indium nitride, and an aluminum nitride and that this optical waveguide contains at least one or more ingredients selected from gallium, indium, niobium, and tantalum more than the cladding layer.

Item 794. The thin film substrate as described in Item 792 or 793, wherein the optical waveguide consists of a thin film which comprises as the main ingredients at least one or more materials selected from a gallium nitride, an indium nitride, and an aluminum nitride and that this optical waveguide contains at least one or more ingredients selected from gallium, indium, niobium, and tantalum more than the cladding layer in the range of not more than 20 mol % by nitride conversion.

Item 795. The thin film substrate as described in Item 791, 792, 793, or 794, wherein the cladding layer consists of a thin film which comprises an aluminum nitride as the main ingredients.

Item 796. The thin film substrate as described in Item 791, 792, 793, 794, or 795, wherein the cladding layer consists of a thin film which comprises an aluminum nitride as the main ingredients and that the optical waveguide consists of a thin film which comprises an aluminum nitride as the main ingredients and has a larger refractive index than this cladding layer.

Item 797. The thin film substrate as described in Item 791, 792, 793, 794, 795, or 796, wherein the cladding layer consists of a thin film which comprises an aluminum nitride as the main ingredients and that the optical waveguide consists of a thin film which comprises an aluminum nitride as the main ingredients and contains at least one or more ingredients selected from gallium, indium, niobium, and tantalum more than this cladding layer.

Item 798. The thin film substrate as described in Item 791, 792, 793, 794, 795, 796, or 797, wherein the cladding layer consists of a thin film which comprises an aluminum nitride as the main ingredients and that the optical waveguide consists of a single crystal thin film which comprises an aluminum nitride as the main ingredients.

Item 799. The thin film substrate as described in Item 771, 772, 773, 774, 775, 776, 777, 778, 779, 780, 781, 782, 783, 784, 785, 786, 787, 788, 789, 790, 791, 792, 793, 794, 795, 796, 797, or 798, wherein the electrode is being formed in an optical waveguide.

Item 800. The thin film substrate as described in Item 791, 792, 793, 794, 795, 796, 797, 798, or 799, wherein the electrode is being formed in the cladding layer.

Item 801. The thin film substrate as described in Item 799 or 800, wherein the electrode is being formed in the optical waveguide and the cladding layer.

Item 802. The thin film substrate as described in Item 799, 800, or 801, wherein the electrode is being formed via a buffer layer.

Item 803. The thin film substrate as described in Item 799, 800, 801, or 802, wherein the buffer layer consists of at least one or more materials selected from SiO₂ and Al₂O₃.

Item 804. The thin film substrate in which a dielectric with a refractive index smaller than the thin film is formed on the thin film comprising at least one or more materials selected from a gallium nitride, an indium nitride, and an aluminum nitride as the main ingredients and was described in Item 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, or 803, and the thin film of a portion in which the dielectric is being formed is used as an optical waveguide.

Item 805. The thin film substrate as described in Item 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, or 803, wherein a metal is formed on the two or more parts of a thin film which comprises as the main ingredients at least one or more materials selected from a gallium nitride, an indium nitride, and an aluminum nitride and that the thin film of a portion in which this metal is not being formed is used as an optical waveguide.

Item 806. The thin film substrate as described in Item 771, 772, 773, 774, 775, 776, 777, 778, 779, 780, 781, 782, 783, 784, 785, 786, 787, 788, 789, 790, 791, 792, 793, 794, 795, 796, 797, 798, 799, 800, 801, 802, or 803, wherein a metal is formed on the two or more parts of a thin film which comprises as the main ingredients at least one or more materials selected from a gallium nitride, an indium nitride, and an aluminum nitride and that the thin film of a portion in which this electrode is being formed is used as an optical waveguide.

Item 807. A manufacture method of a thin film substrate in which a thin film which comprises as the main ingredients at least one or more materials selected from a gallium nitride, an indium nitride, and an aluminum nitride is formed on at least one of the sintered compacts selected from the sintered compact comprising an aluminum nitride as the main ingredients, the sintered compact comprising a ceramic material having the crystal structure of a hexagonal system or a trigonal system as the main ingredients, and the sintered compact comprising a ceramic material as the main ingredients and having optical permeability, and the thin film is formed using the organic compound of at least one or more elements selected from gallium, indium, and aluminum as a main raw material and using at least one or more elements selected from ammonia, nitrogen, and hydrogen as a reactive gas.

Item 808. The manufacture method of the thin film substrate as described in Item 807, wherein the organic compound of the main raw material is an alkyl compound of at least one or more ingredients selected from gallium, indium, and aluminum.

Item 809. The manufacture method of the thin film substrate as described in Item 807 or 808, wherein the organic compound of the main raw material is what comprises as the main ingredients at least one or more materials selected from trimethyl gallium, trimethyl indium, and trimethyl aluminum,

Item 810. A manufacture method of a thin film substrate in which a thin film which comprises as the main ingredients at least one or more materials selected from a gallium nitride, an indium nitride, and an aluminum nitride is formed on at least one of the sintered compacts selected from the sintered compact comprising an aluminum nitride as the main ingredients, the sintered compact comprising a ceramic material having the crystal structure of a hexagonal system or a trigonal system as the main ingredients, and the sintered compact comprising a ceramic material as the main ingredients and having optical permeability, and the thin film is formed using the halogenated compound of at least one or more elements selected from gallium, indium, and aluminum as a main raw material and using at least one or more elements selected from ammonia, nitrogen, and hydrogen as a reactive gas.

Item 811. The manufacture method of the thin film substrate as described in Item 810, wherein the halogenated compound of the main raw material consists of at least one or more materials selected from a fluoride, a chloride, a bromide, and an iodide.

Item 812. The manufacture method of the thin film substrate as described in Item 810 or 811, wherein the halogenated compound of the main raw material is what comprises as the main ingredients at least one or more materials selected from a gallium chloride, a gallium bromide, an indium chloride, an indium bromide, an aluminium chloride, and an aluminum bromide.

Item 813. The manufacture method of the thin film substrate as described in Item 810, 811, or 812, wherein the main raw material consists of an organic compound containing a halogen element.

Item 814. A manufacture method of the thin film substrate in which an optical waveguide is formed on the sintered compact which comprises an aluminum nitride as the main ingredients by the thin film which comprises a gallium nitride, an indium nitride, and an aluminum nitride as the main ingredients, and the optical waveguide consists of a thin film in which at least one or more ingredients selected from gallium, indium, niobium, and tantalum are contained by thermal diffusion or ion implantation in a thin film which comprises as the main ingredients a gallium nitride, an indium nitride, and an aluminum nitride.

Item 815. An optical waveguide which comprises at least one or more materials selected from a gallium nitride, an indium nitride, and an aluminum nitride as the main ingredients and which contains at least one or more ingredients which are selected from niobium and tantalum.

Item 816. The optical waveguide as described in Item 815, wherein it comprises as the main ingredients at least one or more materials selected from a gallium nitride and an aluminum nitride and contains at least one or more ingredients selected from niobium and tantalum.

Item 817. The optical waveguide as described in Item 815 or 816, wherein it comprises an aluminum nitride as the main ingredients and contains at least one or more ingredients selected from niobium and tantalum.

Item 818. The optical waveguide as described in Item 815, 816, or 817, wherein the content of at least one or more ingredients selected from niobium and tantalum is not more than 20 mol % to the main ingredients.

Item 819. The optical waveguide which comprises at least one or more materials selected from a gallium nitride, an indium nitride, and an aluminum nitride as the main ingredients and contains furthermore at least one or more ingredients selected from niobium and tantalum and which was described in Item 815, 816, 817, or 818, and the optical waveguide has at least one of the crystallized states selected from a single crystal, an amorphous state, a polycrystal, and an orientated polycrystal.

Item 820. The optical waveguide as described in Item 819, wherein the crystallized state is a single crystal.

Item 821. The optical waveguide as described in Item 819 or 820, wherein it comprises an aluminum nitride as the main ingredients and consists of a single crystal containing at least one or more ingredients selected from gallium and indium.

Item 822. The optical waveguide as described in Item 819, 820, or 821, wherein it comprises an aluminum nitride as the main ingredients and consists of a single crystal containing at least one or more ingredients selected from gallium and indium not more than 20 mol % to the main ingredients.

Item 823. The optical waveguide which comprises at least one or more materials selected from a gallium nitride, an indium nitride, and an aluminum nitride as the main ingredients and contains furthermore at least one or more ingredients selected from niobium and tantalum and which was described in Item 815, 816, 817, 818, 819, 820, 821, or 822, and the optical waveguide consists of a thin film.

Item 824. An optical waveguide which consists of a bulk single crystal which comprises as the main ingredients at least one or more materials which are selected from a gallium nitride, an indium nitride, and an aluminum nitride.

Item 825. The optical waveguide as described in Item 824, wherein it consists of a bulk single crystal which comprises an aluminum nitride as the main ingredients.

Item 826. The optical waveguide as described in Item 825, wherein it consists of a bulk single crystal which comprises an aluminum nitride as the main ingredients and contains further at least one or more ingredients selected from gallium, indium, niobium, and tantalum.

Item 827. The optical waveguide as described in Item 825 or 826, wherein it consists of a bulk single crystal which comprises an aluminum nitride as the main ingredients and contains further at least one or more ingredients selected from gallium, indium, niobium, and tantalum not more than 20 mol % by nitride conversion.

Item 828. The optical waveguide as described in Item 824, wherein it consists of a bulk single crystal which comprises a gallium nitride as the main ingredients.

Item 829. The optical waveguide as described in Item 828, wherein it consists of a bulk single crystal which comprises a gallium nitride as the main ingredients and contains further at least one or more ingredients selected from indium, niobium, and tantalum.

Item 830. The optical waveguide as described in Item 828 or 829, wherein it consists of a bulk single crystal which comprises a gallium nitride as the main ingredients and contains further at least one or more ingredients selected from indium, niobium, and tantalum not more than 20 mol % by nitride conversion.

Item 831. The optical waveguide which consists of a bulk single crystal comprising at least one or more materials selected from a gallium nitride, an indium nitride, and an aluminum nitride as the main ingredients and which was described in Item 824, 825, 826, 827, 828, 829, or 830, and the optical waveguide consists of a bulk single crystal which contains at least one or more ingredients selected from gallium, indium, niobium, and tantalum.

Item 832. The optical waveguide which consists of a bulk single crystal comprising at least one or more materials selected from a gallium nitride, an indium nitride, and an aluminum nitride as the main ingredients and which was described in Item 831, and the optical waveguide consists of a bulk single crystal which contains at least one or more ingredients selected from gallium, indium, niobium, and tantalum not more than 20 mol % by nitride conversion.

Item 833. A manufacture method of the optical waveguide which consists of a bulk single crystal comprising at least one or more materials selected from a gallium nitride, an indium nitride, and an aluminum nitride as the main ingredients, and the optical waveguide consists of a bulk single crystal whose at least one or more ingredients selected from gallium, indium, niobium, and tantalum is contained by thermal diffusion or ion implantation.

Item 834. A light emitting device constituted by laminating the N type semiconductor layer, luminescence layer, and P type semiconductor layer which consist of a thin film which comprises at least one or more materials selected from a gallium nitride, an indium nitride, and an aluminum nitride as the main ingredients, and the laminated body of N type semiconductor layer, luminescent layer, and P type semiconductor layer is being formed on the sintered compact which comprises an aluminum nitride as the main ingredients.

Item 835. The light emitting device as described in Item 834, wherein the sintered compact which comprises an aluminum nitride as the main ingredients is substrate-like.

Item 836. The light emitting device as described in Item 834 or 835, wherein the sintered compact which comprises an aluminum nitride as the main ingredients has optical permeability.

Item 837. The light emitting device as described in Item 834, 835, or 836, wherein the sintered compact which comprises an aluminum nitride as the main ingredients contains an aluminum nitride not less than 20 volume %.

Item 838. The light emitting device as described in Item 837, wherein the sintered compact which comprises an aluminum nitride as the main ingredients contains an aluminum nitride not less than 50 volume %.

Item 839. The light emitting device as described in Item 834, 835, 836, 837, or 838, wherein the sintered compact which comprises an aluminum nitride as the main ingredients has a conduction via.

Item 840. The light emitting device as described in Item 834, 835, 836, 837, 838, or 839, wherein the sintered compact which comprises an aluminum nitride as the main ingredients has a thin film conductivity material.

Item 841. The light emitting device as described in Item 840, wherein the thin film conductivity material consists of at least one or more materials selected from a metal, an alloy, and a metal nitride.

Item 842. The light emitting device as described in Item 840 or 841, wherein the thin film conductivity material consists of at least one or more elements selected from gold, silver, copper, aluminum, iron, cobalt, nickel, ruthenium, rhodium, palladium, osmium, iridium, platinum, tantalum, molybdenum, tungsten, chromium, titanium, nickel chromium alloy, titanium nitride, zirconium nitride, and tantalum nitride.

Item 843. A light emitting device constituted by laminating the N type semiconductor layer, luminescence layer, and P type semiconductor layer which consist of a thin film which comprises at least one or more materials selected from a gallium nitride, an indium nitride, and an aluminum nitride as the main ingredients, and the laminated body of N type semiconductor layer, luminescent layer, and P type semiconductor layer is being formed on the sintered compact which comprises as the main ingredients a ceramic material which has at least one of the crystal structures selected from a hexagonal system or a trigonal system.

Item 844. The light emitting device as described in Item 843, wherein the sintered compact which comprises as the main ingredients a ceramic material which has at least one of the crystal structures selected from a hexagonal system or a trigonal system is substrate-like.

Item 845. The light emitting device as described in Item 843 or 844, wherein the sintered compact which comprises as the main ingredients a ceramic material which has at least one of the crystal structures selected from a hexagonal system or a trigonal system has optical permeability.

Item 846. The light emitting device as described in Item 843, 844, or 845, wherein the sintered compact which comprises as the main ingredients a ceramic material which has at least one of the crystal structures selected from a hexagonal system or a trigonal system is at least one selected from a silicon carbide, a silicon nitride, a beryllium oxide, a zinc oxide, and an aluminum oxide.

Item 847. The light emitting device constituted by laminating the N type semiconductor layer, luminescent layer, and P type semiconductor layer which consist of a thin film comprising at least one or more materials selected from a gallium nitride, an indium nitride, and an aluminum nitride as the main ingredients, as described in Item 843, 844, 845, or 846, wherein the laminated body of the N type semiconductor layer, luminescence layer, and P type semiconductor layer is being formed on the sintered compact which comprises a zinc oxide as the main ingredients.

Item 848. The light emitting device as described in Item 847, wherein the sintered compact which comprises a zinc oxide as the main ingredients contains a zinc oxide ingredient not less than 55.0 mol % by ZnO conversion.

Item 849. The light emitting device as described in Item 847 or 848, wherein the sintered compact which comprises a zinc oxide as the main ingredients has electrical conductivity.

Item 850. The light emitting device as described in Item 847, 848, or 849, wherein the sintered compact which comprises a zinc oxide as the main ingredients has electrical conductivity not more than 1×10² Ω·cm as electric resistivity in room temperature.

Item 851. The light emitting device as described in Item 847, 848, 849, or 850, wherein the sintered compact which comprises a zinc oxide as the main ingredients has optical permeability and electrical conductivity.

Item 852. The light emitting device constituted by laminating the N type semiconductor layer, luminescent layer, and P type semiconductor layer which consist of a thin film comprising at least one or more materials selected from a gallium nitride, an indium nitride, and an aluminum nitride as the main ingredients, as described in Item 843, 844, 845, or 846, wherein the laminated body of the N type semiconductor layer, luminescence layer, and P type semiconductor layer is being formed on the sintered compact which comprises a beryllium oxide as the main ingredients.

Item 853. The light emitting device as described in Item 852, wherein the sintered compact which comprises a beryllium oxide as the main ingredients contains a beryllium oxide ingredient not less than 65.0 mol % by BeO conversion.

Item 854. The light emitting device constituted by laminating the N type semiconductor layer, luminescent layer, and P type semiconductor layer which consist of a thin film comprising at least one or more materials selected from a gallium nitride, an indium nitride, and an aluminum nitride as the main ingredients, as described in Item 843, 844, 845, or 846, wherein the laminated body of the N type semiconductor layer, luminescence layer, and P type semiconductor layer is being formed on the sintered compact which comprises an aluminum oxide as the main ingredients.

Item 855. The light emitting device as described in Item 854, wherein the sintered compact which comprises a zinc oxide as the main ingredients contains an aluminum oxide ingredient not less than 55.0 mol % by Al₂O₃ conversion.

Item 856. The light emitting device constituted by laminating the N type semiconductor layer, luminescent layer, and P type semiconductor layer which consist of a thin film comprising at least one or more materials selected from a gallium nitride, an indium nitride, and an aluminum nitride as the main ingredients, as described in Item 843, 844, 845, or 846, wherein the laminated body of the N type semiconductor layer, luminescence layer, and P type semiconductor layer is being formed on the sintered compact which comprises a silicon carbide as the main ingredients.

Item 857. The light emitting device constituted by laminating the N type semiconductor layer, luminescent layer, and P type semiconductor layer which consist of a thin film comprising at least one or more materials selected from a gallium nitride, an indium nitride, and an aluminum nitride as the main ingredients, as described in Item 843, 844, 845, or 846, wherein the laminated body of the N type semiconductor layer, luminescence layer, and P type semiconductor layer is being formed on the sintered compact which comprises a silicon nitride as the main ingredients.

Item 858. A light emitting device constituted by laminating the N type semiconductor layer, luminescence layer, and P type semiconductor layer which consist of a thin film which comprises at least one or more materials selected from a gallium nitride, an indium nitride, and an aluminum nitride as the main ingredients, wherein the laminated body of N type semiconductor layer, luminescent layer, and P type semiconductor layer is being formed on the sintered compact which comprises a ceramic material as the main ingredients and which has optical permeability.

Item 859. The light emitting device as described in Item 858, wherein the sintered compact which comprises a ceramic material as the main ingredients and which has optical permeability is substrate-like.

Item 860. The light emitting device as described in Item 858 or 859, wherein the ceramic material is at least one or more materials selected from a zirconium dioxide, a magnesium oxide, a magnesium aluminate, a titanium oxide, a barium titanate, a lead titanate zirconate, rare earth element oxides, a thorium dioxide, various ferrites, a mullite, a forsterite, a steatite, and glass ceramics.

Item 861. The light emitting device constituted by laminating the N type semiconductor layer, luminescent layer, and P type semiconductor layer which consist of a thin film comprising at least one or more materials selected from a gallium nitride, an indium nitride, and an aluminum nitride as the main ingredients, as described in Item 858, 859, or 860, wherein the laminated body of the N type semiconductor layer, luminescence layer, and P type semiconductor layer is being formed on the sintered compact which comprises a zirconium dioxide as the main ingredients.

Item 862. The light emitting device constituted by laminating the N type semiconductor layer, luminescent layer, and P type semiconductor layer which consist of a thin film comprising at least one or more materials selected from a gallium nitride, an indium nitride, and an aluminum nitride as the main ingredients, as described in Item 858, 859, or 860, wherein the laminated body of the N type semiconductor layer, luminescence layer, and P type semiconductor layer is being formed on the sintered compact which comprises a magnesium oxide as the main ingredients.

Item 863. The light emitting device constituted by laminating the N type semiconductor layer, luminescent layer, and P type semiconductor layer which consist of a thin film comprising at least one or more materials selected from a gallium nitride, an indium nitride, and an aluminum nitride as the main ingredients, as described in Item 858, 859, or 860, wherein the laminated body of the N type semiconductor layer, luminescence layer, and P type semiconductor layer is being formed on the sintered compact which comprises a magnesium aluminate as the main ingredients.

Item 864. The light emitting device constituted by laminating the N type semiconductor layer, luminescent layer, and P type semiconductor layer which consist of a thin film comprising at least one or more materials selected from a gallium nitride, an indium nitride, and an aluminum nitride as the main ingredients, as described in Item 858, 859, or 860, wherein the laminated body of the N type semiconductor layer, luminescence layer, and P type semiconductor layer is being formed on the sintered compact which comprises a yttrium oxide as the main ingredients.

Item 865. The light emitting device constituted by laminating the N type semiconductor layer, luminescent layer, and P type semiconductor layer which consist of a thin film comprising at least one or more materials selected from a gallium nitride, an indium nitride, and an aluminum nitride as the main ingredients, as described in Item 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, or 864, wherein the laminated body of the N type semiconductor layer, luminescence layer, and P type semiconductor layer is being formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, and the optical transmissivity of the sintered compact is at least not less than 1%.

Item 866. The light emitting device as described in Item 865, wherein the optical transmissivity of the sintered compact is not less than 10%.

Item 867. The light emitting device as described in Item 865 or 866, wherein the optical transmissivity of the sintered compact is not less than 20%.

Item 868. The light emitting device as described in Item 865, 866, or 867, wherein the optical transmissivity of the sintered compact is not less than 30%.

Item 869. The light emitting device as described in Item 865, 866, 867, or 868, wherein the optical transmissivity of the sintered compact is not less than 40%.

Item 870. The light emitting device as described in Item 865, 866, 867, 868, or 869, wherein the optical transmissivity of the sintered compact is not less than 50%.

Item 871. The light emitting device as described in Item 865, 866, 867, 868, 869, or 870, wherein the optical transmissivity of the sintered compact is not less than 60%.

Item 872. The light emitting device as described in Item 865, 866, 867, 868, 869, 870, or 871, wherein the optical transmissivity of the sintered compact is not less than 80%.

Item 873. The light emitting device as described in Item 865, 866, 867, 868, 869, 870, 871, or 872, wherein the optical transmissivity of the sintered compact is not less than 85%.

Item 874. The light emitting device constituted by laminating the N type semiconductor layer, luminescent layer, and P type semiconductor layer which consist of a thin film comprising at least one or more materials selected from a gallium nitride, an indium nitride, and an aluminum nitride as the main ingredients, as described in Item 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, or 864, wherein the laminated body of the N type semiconductor layer, luminescence layer, and P type semiconductor layer is being formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, and the optical transmissivity of the sintered compact is smaller than 1%.

Item 875. The light emitting device as described in Item 874, wherein the optical transmissivity of the sintered compact is 0%.

Item 876. The light emitting device as described in Item 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, or 875, wherein the optical permeability or optical transmissivity is a thing in the light of the range of 200nm-800nm wavelength at least.

Item 877. The light emitting device constituted by laminating the N type semiconductor layer, luminescent layer, and P type semiconductor layer which consist of a thin film comprising at least one or more materials selected from a gallium nitride, an indium nitride, and an aluminum nitride as the main ingredients, as described in Item 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, or 876, wherein the laminated body of the N type semiconductor layer, luminescence layer, and P type semiconductor layer is being formed on at least one of the sintered compacts selected from the sintered compact which comprises an aluminum nitride as the main ingredients and which formed the thin film comprising at least one or more materials selected from a gallium nitride, an indium nitride, and an aluminum nitride as the main ingredients, the sintered compact which comprises as the main ingredients a ceramic material having at least one of the crystal structures selected from a hexagonal system or a trigonal system and which formed the thin film comprising at least one or more materials selected from a gallium nitride, an indium nitride, and an aluminum nitride as the main ingredients, and the sintered compact which comprises a ceramic material as the main ingredients and has optical permeability and which formed the thin film comprising at least one or more materials selected from a gallium nitride, an indium nitride, and an aluminum nitride as the main ingredients.

Item 878. The light emitting device as described in Item 877, wherein at least one of the sintered compacts selected from the sintered compact which comprises an aluminum nitride as the main ingredients and which formed the thin film comprising at least one or more materials selected from a gallium nitride, an indium nitride, and an aluminum nitride as the main ingredients, the sintered compact which comprises as the main ingredients a ceramic material having at least one of the crystal structures selected from a hexagonal system or a trigonal system and which formed the thin film comprising at least one or more materials selected from a gallium nitride, an indium nitride, and an aluminum nitride as the main ingredients, and the sintered compact which comprises a ceramic material as the main ingredients and has optical permeability and which formed the thin film comprising at least one or more materials selected from a gallium nitride, an indium nitride, and an aluminum nitride as the main ingredients, is substrate-like.

Item 879. The light emitting device as described in Item 877 or 878, wherein the thin film which comprises as the main ingredients at least one or more materials selected from a gallium nitride, an indium nitride, and an aluminum nitride and which is being formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, has at least one of the crystallized states selected from a single crystal, an amorphous state, a polycrystal, and an orientated polycrystal.

Item 880. The light emitting device as described in Item 877, 878, or 879, wherein at least a part of the thin film which comprises as the main ingredients at least one or more materials selected from a gallium nitride, an indium nitride, and an aluminum nitride consists of a single crystal.

Item 881. The light emitting device as described in Item 880, wherein the thin film which comprises as the main ingredients at least one or more materials selected from a gallium nitride, an indium nitride, and an aluminum nitride consists only of a single crystal.

Item 882. The light emitting device as described in Item 877, 878, 879, 880, or 881, wherein the thin film which comprises as the main ingredients at least one or more materials selected from a gallium nitride, an indium nitride, and an aluminum nitride and which is being formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, is a single layer.

Item 883. The light emitting device as described in Item 877, 878, 879, 880, 881, or 882, wherein the thin film which comprises as the main ingredients at least one or more materials selected from a gallium nitride, an indium nitride, and an aluminum nitride and which is being formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, is being constituted by at least two or more layers.

Item 884. The light emitting device as described in Item 883, wherein each layer of the thin film which is being constituted with at least two or more layers has at least one of the crystallized states selected from a single crystal, an orientated polycrystal, a polycrystal, and an amorphous state.

Item 885. The light emitting device as described in Item 883 or 884 characterized in that in the thin film which is being constituted with at least two or more layers, at least one or more layers of a single crystal thin film which comprises as the main ingredients at least one or more materials selected from a gallium nitride, an indium nitride, and an aluminum nitride are formed furthermore on it, after at least one or more layers of the thin film which comprises as the main ingredients at least one or more materials selected from a gallium nitride, an indium nitride, and an aluminum nitride and which has at least one of the crystallized states selected from a single crystal, an orientated polycrystal, a polycrystal, and an amorphous state are formed on at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 886. The light emitting device as described in Item 885, wherein in the thin film which is being constituted with at least two or more layers, at least one or more layers of a single crystal thin film which comprises as the main ingredients at least one or more materials selected from a gallium nitride, an indium nitride, and an aluminum nitride are formed furthermore on it, after at least one or more layers of the thin film which comprises as the main ingredients at least one or more materials selected from a gallium nitride, an indium nitride, and an aluminum nitride and which has at least one of the crystallized states selected from an orientated polycrystal, a polycrystal, and an amorphous are formed on at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 887: The light emitting device as described in Item 885 or 886, wherein in the thin film which is being constituted with at least two or more layers, at least one or more layers of the single crystal thin film which comprises as the main ingredients at least one or more materials selected from a gallium nitride, an indium nitride, and an aluminum nitride are formed furthermore on it, after at least one or more layers of an amorphous thin film which comprises as the main ingredients at least one or more materials selected from a gallium nitride, an indium nitride, and an aluminum nitride are formed on at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 888. The light emitting device as described in Item 885 or 886, wherein in the thin film which is being constituted with at least two or more layers, at least one or more layers of the single crystal thin film which comprises as the main ingredients at least one or more materials selected from a gallium nitride, an indium nitride, and an aluminum nitride are formed furthermore on it, after at least one or more layers of a polycrystalline thin film which comprises as the main ingredients at least one or more materials selected from a gallium nitride, an indium nitride, and an aluminum nitride are formed on at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 889. The light emitting device as described in Item 885 or 886, wherein in the thin film which is being constituted with at least two or more layers, at least one or more layers of the single crystal thin film which comprises as the main ingredients at least one or more materials selected from a gallium nitride, an indium nitride, and an aluminum nitride are formed furthermore on it, after at least one or more layers of an orientated polycrystalline thin film which comprises as the main ingredients at least one or more materials selected from a gallium nitride, an indium nitride, and an aluminum nitride are formed on at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 890. The light emitting device as described in Item 883, 884, 885, 886, 887, 888, or 889, wherein in the thin film which is being constituted with at least two or more layers, at least one or more layers of the thin film which comprises as the main ingredients at least one or more materials selected from a gallium nitride, an indium nitride, and an aluminum nitride and has at least one of the crystallized states selected from a single crystal, an orientated polycrystal, a polycrystal, and an amorphous state are formed furthermore on it, after at least one or more layers of the thin film which comprises as the main ingredients at least one or more materials selected from a gallium nitride, an indium nitride, and an aluminum nitride and has at least one of the crystallized states selected from a single crystal, an orientated polycrystal, a polycrystal, and an amorphous state are formed on at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 891. The light emitting device as described in Item 883, 884, 885, or 890, wherein in the thin film which is being constituted with at least two or more layers, all layers are being constituted with only a single crystal.

Item 892. The light emitting device as described in Item 877, 878, 879, 880, 881, 882, 883, 884, 885, 886, 887, 888, 889, 890, or 891, wherein the single crystal thin film which comprises as the main ingredients at least one or more materials selected from a gallium nitride, an indium nitride, and an aluminum nitride is being formed on the surface of at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 893. The light emitting device as described in Item 877, 878, 879, 880, 881, 882, 883, 884, 885, 886, 887, 888, 889, 890, 891, or 892, wherein the C axis of the single crystal thin film which comprises as the main ingredients at least one or more materials selected from a gallium nitride, an indium nitride, and an aluminum nitride is being formed in the perpendicular direction to the surface of at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 894. The light emitting device as described in Item 877, 878, 879, 880, 881, 882, 883, 884, 885, 886, 887, 888, 889, 890, 891, or 892, wherein the C axis of the single crystal thin film which comprises as the main ingredients at least one or more materials selected from a gallium nitride, an indium nitride, and an aluminum nitride is being formed in the level direction to the surface of at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 895. The light emitting device as described in Item 877, 878, 879, 880, 881, 882, 883, 884, 885, 886, 887, 888, 889, 890, 891, or 892, wherein the C axis of the orientated polycrystalline thin film which comprises as the main ingredients at least one or more materials selected from a gallium nitride, an indium nitride, and an aluminum nitride is being formed in the perpendicular direction to the surface of at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 896. The light emitting device as described in Item 877, 878, 879, 880, 881, 882, 883, 884, 885, 886, 887, 888, 889, 890, 891, or 892, wherein the C axis of the orientated polycrystalline thin film which comprises as the main ingredients at least one or more materials selected from a gallium nitride, an indium nitride, and an aluminum nitride is being formed in the level direction to the surface of at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 897. The light emitting device as described in Item 877, 878, 879, 880, 881, 882, 883, 884, 885, 886, 887, 888, 889, 890, 891, 892, 893, 894, 895, or 896, wherein the thin film which comprises as the main ingredients at least one or more materials selected from a gallium nitride, an indium nitride, and an aluminum nitride and which is being formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, has electrical conductivity.

Item 898. The light emitting device as described in Item 897, wherein the electric resistivity of the thin film which has electrical conductivity and comprises as the main ingredients at least one or more materials selected from a gallium nitride, an indium nitride, and an aluminum nitride is not more than 1×10⁴ Ω·cm in room temperature.

Item 899. The light emitting device as described in Item 897 or 898, wherein the electric resistivity of the thin film which has electrical conductivity and comprises as the main ingredients at least one or more materials selected from a gallium nitride, an indium nitride, and an aluminum nitride is not more than 1×10² Ω·cm in room temperature.

Item 900. The light emitting device as described in Item 897, 898, or 899, wherein the electric resistivity of the thin film which has electrical conductivity and comprises as the main ingredients at least one or more materials selected from a gallium nitride, an indium nitride, and an aluminum nitride is not more than 1×10¹ Ω·cm in room temperature.

Item 901. The light emitting device as described in Item 897, 898, 899, or 900, wherein the electric resistivity of the thin film which has electrical conductivity and comprises as the main ingredients at least one or more materials selected from a gallium nitride, an indium nitride, and an aluminum nitride is not more than 1×10⁰ Ω·cm in room temperature.

Item 902. The light emitting device as described in Item 877, 878, 879, 880, 881, 882, 883, 884, 885, 886, 887, 888, 889, 890, 891, 892, 893, 894, 895, 896, 897, 898, 899, 900, or 901, wherein the thin film being formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, comprises as the main ingredients a composite expressed with the chemical formula of AlₓGa₁₋ₓN (0≦x≦1.0).

Item 903. The light emitting device as described in Item 877, 878, 879, 880, 881, 882, 883, 884, 885, 886, 887, 888, 889, 890, 891, 892, 893, 894, 895, 896, 897, 898, 899, 900, 901, or 902, wherein the thickness of the thin film which comprises as the main ingredients at least one or more materials selected from a gallium nitride, an indium nitride, and an aluminum nitride and which is being formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, is not less than 0.5 nm.

Item 904. The light emitting device as described in Item 903, wherein the thickness of the thin film being formed is not less than 0.3 μm.

Item 905. The light emitting device as described in Item 903 or 904, wherein the thickness of the thin film being formed is not less than 3.5 μm.

Item 906. The light emitting device as described in Item 903, 904, or 905, wherein the thickness of the thin film being formed is not less than 10 μm.

Item 907. The light emitting device as described in Item 903, 904, 905, or 906, wherein the thickness of the thin film being formed is not less than 50 μm.

Item 908. The light emitting device as described in Item 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, or 907, wherein the thickness of the thin film which comprises as the main ingredients at least one or more materials selected from a gallium nitride, an indium nitride, and an aluminum nitride and which is being formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, is not more than 1000 μm.

Item 909. The light emitting device as described in Item 908, wherein the thickness of the thin film being formed is not more than 500 μm.

Item 910. The light emitting device as described in Item 877, 878, 879, 880, 881, 882, 883, 884, 885, 886, 887, 888, 889, 890, 891, 892, 893, 894, 895, 896, 897, 898, 899, 900, 901, 902, 903, 964, 905, 906, 907, 908, or 909, wherein the single crystal thin film which comprises as the main ingredients at least one or more materials selected from a gallium nitride, an indium nitride, and an aluminum nitride and which is being formed on at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, has the crystallinity not more than 3600 seconds as half width of the rocking curve of the X ray diffraction line from the lattice plane of a Miller Index (002).

Item 911. The light emitting device as described in Item 910, wherein the currently formed single crystal thin film which comprises as the main ingredients at least one or more materials selected from a gallium nitride, an indium nitride, and an aluminum nitride has the crystallinity not more than 300 seconds as half width of the rocking curve of the X ray diffraction line from the lattice plane of a Miller Index (002).

Item 912. The light emitting device as described in Item 910 or 911, wherein the currently formed single crystal thin film which comprises as the main ingredients at least one or more materials selected from a gallium nitride, an indium nitride, and an aluminum nitride has the crystallinity not more than 240 seconds as half width of the rocking curve of the X ray diffraction line from the lattice plane of a Miller Index (002).

Item 913. The light emitting device as described in Item 910, 911, or 912, wherein the currently formed single crystal thin film which comprises as the main ingredients at least one or more materials selected from a gallium nitride, an indium nitride, and an aluminum nitride has the crystallinity not more than 200 seconds as half width of the rocking curve of the X ray diffraction line from the lattice plane of a Miller Index (002).

Item 914. The light emitting device as described in Item 910, 911, 912, or 913, wherein the currently formed single crystal thin film which comprises as the main ingredients at least one or more materials selected from a gallium nitride, an indium nitride, and an aluminum nitride has the crystallinity not more than 150 seconds as half width of the rocking curve of the X ray diffraction line from the lattice plane of a Miller Index (002).

Item 915. The light emitting device as described in Item 910, 911, 912, 913, or 914, wherein the currently formed single crystal thin film which comprises as the main ingredients at least one or more materials selected from a gallium nitride, an indium nitride, and an aluminum nitride has the crystallinity not more than 130 seconds as half width of the rocking curve of the X ray diffraction line from the lattice plane of a Miller Index (002).

Item 916. The light emitting device as described in Item 910, 911, 912, 913, 914, or 915, wherein the currently formed single crystal thin film which comprises as the main ingredients at least one or more materials selected from a gallium nitride, an indium nitride, and an aluminum nitride has the crystallinity not more than 100 seconds as half width of the rocking curve of the X ray diffraction line from the lattice plane of a Miller Index (002).

Item 917. The light emitting device constituted by laminating the N type semiconductor layer, luminescence layer, and P type semiconductor layer which consist of a thin film which comprises as the main ingredients at least one or more materials selected from a gallium nitride, an indium nitride, and an aluminum nitride onto at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, as described in Item 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, or 916, wherein at least one selected from N type semiconductor layer, luminescence layer, and P type semiconductor layer is a single layer.

Item 918. The light emitting device constituted by laminating the N type semiconductor layer, luminescence layer, and P type semiconductor layer which consist of a thin film which comprises as the main ingredients at least one or more materials selected from a gallium nitride, an indium nitride, and an aluminum nitride onto at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, as described in Item 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, 916, or 917, wherein at least one selected from N type semiconductor layer, luminescence layer, and P type semiconductor layer is at least two or more layers.

Item 919. The light emitting device as described in Item 918, wherein this N type semiconductor layer, luminescence layer, and P type semiconductor layer consist of an epitaxially grown single crystal thin film which comprises as the main ingredients at least one or more materials selected from a gallium nitride, an indium nitride, and an aluminum nitride. Item 920. The light emitting device constituted by laminating the N type semiconductor layer, luminescence layer, and P type semiconductor layer which consist of a thin film which comprises as the main ingredients at least one or more materials selected from a gallium nitride, an indium nitride, and an aluminum nitride onto at least one of the sintered compacts selected from the sintered compact comprising an aluminum nitride as the main ingredients, the sintered compact comprising a ceramic material having at least one of the crystal structures selected from a hexagonal system or a trigonal system as the main ingredients, and the sintered compact comprising a ceramic material as the main ingredients and having optical permeability, as described in Item 834, 835, 836, 837, 838, 839, 840, 841, 842, 843, 844, 845, 846, 847, 848, 849, 850, 851, 852, 853, 854, 855, 856, 857, 858, 859, 860, 861, 862, 863, 864, 865, 866, 867, 868, 869, 870, 871, 872, 873, 874, 875, 876, 877, 878, 879, 880, 881, 882, 883, 884, 885, 886, 887, 888, 889, 890, 891, 892, 893, 894, 895, 896, 897, 898, 899, 900, 901, 902, 903, 904, 905, 906, 907, 908, 909, 910, 911, 912, 913, 914, 915, 916, 917, 918, or 919, wherein the buffer layer is being formed by the thin film which comprises as the main ingredients at least one or more materials selected from a gallium nitride, an indium nitride, and an aluminum nitride between this laminated body of the N type semiconductor layer, a luminescence layer, and P type semiconductor layer and at least one of the sintered compacts selected from the sintered compact which comprises an aluminum nitride as the main ingredients, the sintered compact which comprises as the main ingredients a ceramic material which has at least one of the crystal structures selected from a hexagonal system or a trigonal system, and the sintered compact which comprises a ceramic material as the main ingredients and which has optical permeability.

Item 921. The light emitting device as described in Item 920, wherein the buffer layer consists of a thin film which has at least one of the crystallized states selected from a single crystal, an orientated polycrystal, a polycrystal, and an amorphous state.

Item 922. The light emitting device as described in Item 920 or 921, wherein the buffer layer consists of a thin film which has at least one of the crystallized states selected from an orientated polycrystal, a polycrystal, and an amorphous.

Item 923. The light emitting device as described in Item 920, 921, or 922, wherein the buffer layer consists of an amorphous thin film.

Item 924. The field emission material, wherein the single crystal thin film which was formed on the sintered compact comprising an aluminum nitride as the main ingredients and comprises as the main ingredients at least one or more materials selected from a gallium nitride, an indium nitride, and an aluminum nitride is used.

Item 925. The field emission material as described in Item 924, wherein the N type semiconductor-ized single crystal thin film which was formed on the sintered compact comprising an aluminum nitride as the main ingredients and comprises as the main ingredients at least one or more materials selected from a gallium nitride, an indium nitride, and an aluminum nitride is used.

Item 926. The field emission material as described in Item 924 or 925, wherein the doping element for semiconductor-izing a single crystal thin film which comprises as the main ingredients at least one or more materials selected from a gallium nitride, an indium nitride, and an aluminum nitride into N type is silicon.

[The 2nd Aspect of this Invention]

Next, the 2nd aspect of this invention is explained.

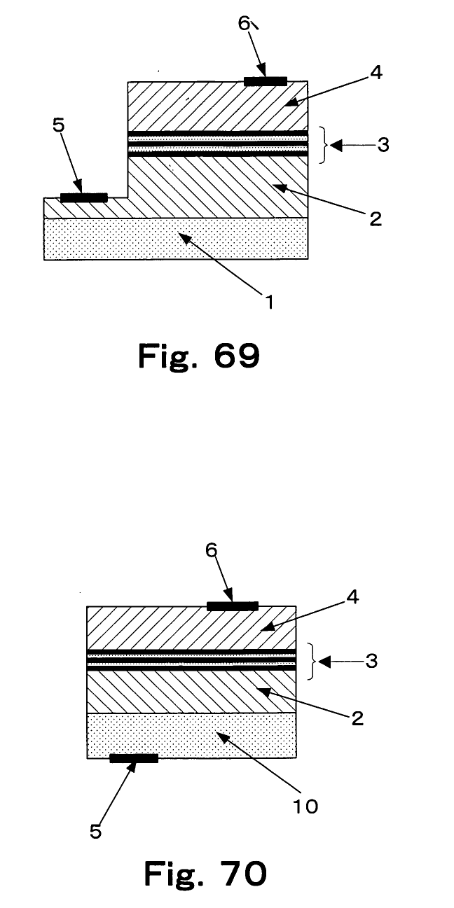

It is shown by FIG. 69-FIG. 103 as a drawing about the 2nd aspect of this invention.

The contents of the mark (reference number) used in FIG. 69-FIG. 103 are as being shown below.

That is,

1: Substrate for light emitting device production (electric insulation)

2: N type semiconductor thin film layer which comprises as the main ingredients at least one or more materials selected from a gallium nitride, an indium nitride, and an aluminum nitride.

3: Luminescence layer which comprises as the main ingredients at least one or more materials selected from a gallium nitride, an indium nitride, and an aluminum nitride.

4: P type semiconductor thin film layer which comprises as the main ingredients at least one or more materials selected from a gallium nitride, an indium nitride, and an aluminum nitride.

5: External electrode

6: External electrode

10: Substrate for light emitting device production (electrical conductivity)

20: Substrate for light emitting device mounting

21: Light emitting device

22: Emitted light to the side of the substrate surface on which a light emitting device is mounted

23: Light from the light emitting device which penetrates a substrate and is emitted to the substrate exterior

24: Light from the light emitting device which penetrates a substrate at the side wall portion forming a cavity space and is emitted to the substrate exterior

25: Wire

26: Surface electric circuit

27: Surface electric circuit

29: Non-wire-like connection material

30: Substrate for light emitting device mounting which has cavity space (cavity)

31: Cavity space (cavity)

32: Lid

33: Side wall inside cavity space

34: Base

35: Frame

36: Junction part

37: Seal part

38: Light emitting device mounting part

40: Conduction via

41: Surface electric circuit

42: Surface electric circuit

43: Internal electric circuit

50: Submount

51: Electric circuit which was formed on the submount

52: Electric circuit formed on the submount side

53: Conduction via formed in the submount

60: Light from the light emitting device irradiated to the substrate surface on which a light emitting device is mounted

61: Reflected light of the substrate surface on which a reflective prevention material and a reflective material are not formed

70: Reflective prevention material

71: Light from the light emitting device which penetrates a substrate and is emitted to the substrate exterior

72: Light from the light emitting device which penetrates a substrate and is emitted to the substrate exterior

73: Light from the light emitting device which penetrates a substrate and is emitted to the substrate exterior

74: Light from the light emitting device which penetrates the substrate forming a reflective prevention material and is emitted to the substrate exterior

80: Reflective material

81: Reflected light by a reflective material

82: Light from the light emitting device which penetrates the substrate forming the reflective material and is emitted to the substrate exterior,

83: Reflected light reflected by the reflective material in the inside of a substrate for light emitting device mounting which has a cavity space

84: Emitted light which penetrated the substrate portion on which a reflective material is not formed

85: Reflected light reflected by the reflective material in the inside of a substrate for light emitting device mounting which has a cavity space

86: Light emitted to the substrate exterior, penetrating the substrate of the portion on which a reflective material is not formed

87: Light emitted to the substrate exterior, penetrating the substrate of the portion on which a reflective prevention material is being formed

88: Reflected light reflected by the reflective material in the inside of a substrate for light emitting device mounting which has a cavity space

90: Light irradiated towards the side wall portion and lid which form cavity space from a light emitting device

91: Light emitted to the substrate exterior, penetrating the substrate of the portion on which a reflective prevention material is being formed

92: Light emitted to the substrate exterior, penetrating the substrate of the portion on which a reflective prevention material is being formed

100: Substrate

101: Reflective part

102: Luminescence from a light emitting device

103: Portion for containing

104: Light which penetrated the substrate and was emitted to the substrate exterior from the light emitting device

110: Material in which light penetrates linearly

111: Incidence light

112: Penetration light

120: Material by which a penetration light becomes into the scattered light

121: Incidence light

122: Penetration light

The substrate for light emitting device mounting according to this invention consists of a sintered compact which comprises an aluminum nitride as the main ingredients and which has optical permeability.

This invention has the feature in the point which enabled luminescence from a light emitting device to emit to the substrate exterior efficiently not only by a conventional reflective function but also by using the optical permeability of the sintered compact which comprises an aluminum nitride as the main ingredients.

It became possible to emit efficiently luminescence from a light emitting device into all the directions of the space where a light emitting device is at the center, using the sintered compact which comprises an aluminum nitride as the main ingredients and which has optical permeability, as a substrate for light emitting device mounting.

That is, luminescence from this light emitting device can be efficiently emitted to the substrate exterior not only at the substrate surface side on which this light emitting device was mounted but also at the substrate surface side opposite to the surface where this light emitting device was mounted.

If a light reflex prevention function is given to the substrate for light emitting device mounting by using the sintered compact which comprises an aluminum nitride as the main ingredients and formed the reflective prevention material as a substrate for light emitting device mounting, luminescence from a light emitting device will be emitted to the exterior more strongly from the substrate surface side opposite to the surface where this light emitting device was mounted.

If a light reflex function is given to the substrate for light emitting device mounting by using the sintered compact which comprises an aluminum nitride as the main ingredients and formed the reflective material as a substrate for light emitting device mounting, it will become possible to also make luminescence from a light emitting device emit into a specific direction strongly.

In other words, the effect of this invention is also in the point which can control comparatively easily the intensity of luminescence from this light emitting device to all the directions of space of the circumference of a light emitting device, without being accompanied by big loss.

That is, the intensity of luminescence from this light emitting device emitted to all the directions of space of the circumference of a light emitting device can be controlled comparatively easily without being accompanied by big loss by using the sintered compact which comprises an aluminum nitride as the main ingredients and which has optical permeability as a substrate for light emitting device mounting and by adding a light reflex prevention function or a light reflex function to this substrate for light emitting device mounting further.

Thus, in this invention, sufficient effect is not acquired only by using the sintered compact which only comprises an aluminum nitride as the main ingredients as a substrate for light emitting device mounting.

It is important to use what is optical permeability as a sintered compact which comprises an aluminum nitride as the main ingredients as mentioned above.

In this invention, luminescence from this light emitting device can be efficiently emitted to the substrate exterior not only at the substrate surface side on which this light emitting device was mounted but also at the substrate surface side opposite to the surface where this light emitting device was mounted by using the sintered compact which comprises an aluminum nitride as the main ingredients and is optical permeability as mentioned above.

Such an effect is usually acquired in the sintered compact which comprises an aluminum nitride as the main ingredients and which has optical permeability of optical transmissivity not less than 1%.

In the above-mentioned sintered compact which comprises an aluminum nitride as the main ingredients and which has optical permeability, a bigger effect comes to be acquired where optical transmissivity is not less than 5%.

In the above-mentioned sintered compact which comprises an aluminum nitride as the main ingredients and which has optical permeability, an effect comes to be accepted clearly where optical transmissivity is not less than 10%.

In this invention, the sintered compact which comprises an aluminum nitride as the main ingredients and which has optical permeability is usually what has the optical transmissivity not less than 1% as mentioned above.

The optical permeability in this invention means the permeability to the light of the range of 200 nm-800 nm wavelength at least.

Unless reference is made especially in this invention, “visible light” is the light of the range of 380 nm-800 nm wavelength.

“Ultraviolet light” is the light with a wavelength not more than 380 nm.

Unless reference is made especially in this invention, a “optical transmissivity of visible light” is the transmissivity to the light of the range of 380 nm-800 nm wavelength.

“Ultraviolet light transmissivity” is the permeability to the light of not more than 380 nm.

Unless reference is made especially in this invention, the optical transmissivity to the above-mentioned light of the range of the 200 nm-800 nm wavelength is measured by using monochromatic light with a wavelength 605 nm on behalf of the light of the range of 200 nm-800 nm wavelength.

It was measured by the sintered compact which comprises an aluminum nitride as the main ingredients and is the diameter of 25.4 mm and the thickness of 0.5 mm as a sample.

Usually, the light of predetermined wavelength is applied to the above-mentioned substrate sample for light emitting device loading by using a spectrophotometer etc., the intensity of an incidence light and the intensity of a transmitted light are measured, and the ratio is expressed with percentage.

The optical transmissivity in this invention sets the above-mentioned sample for measurement so that the window of an integrating sphere may be covered, it collects all penetration light, and expresses the intensity ratio of all these penetration light and incidence light with percentage.

In this invention, measurement of the optical transmissivity of a sintered compact which comprises an aluminum nitride as the main ingredients and is used as a substrate for light emitting device mounting is usually what was measured by the sample form of the diameter of 25.4 mm and thickness of 0.5 mm using monochromatic light with 605 nm wavelength as mentioned above.

However, the form and size of the sample which measures optical transmissivity may not be especially what was shown above, and can use arbitrary things.

For example, even if it is what is small form, such as diameter 1 mm and thickness 0.5 mm, it can measure easily.

The measurement equipment of optical transmissivity can use not only the method of using a spectrophotometer but also the arbitrary method suitably.

Although the optical transmissivity of transparent bodies, such as glass, is usually measured as straight line transmissivity, as for optical transmissivity of ceramic material, such as a sintered compact which comprises an aluminum nitride as the main ingredients, generally, incidence light is scattered about inside a sintered compact, and is not penetrated linearly, but is penetrated in all the directions in the state where it was scattered about.

Therefore, the intensity of penetration light becomes what collected all scattered light without such directivity.

In this invention, the optical transmissivity of the sintered compact which comprises an aluminum nitride as the main ingredients and a sintered compact comprising other ceramic materiala as the main ingredients is measured as such total transmissivity, and differs from the straight line transmissivity of transparent bodies, such as glass.

Optical transmissivity changes with the thickness of a sample, when the above-mentioned sintered compact which comprises an aluminum nitride as the main ingredients according to this invention is actually used as the substrate for thin film formation, a thin film substrate, or a substrate for light emitting device production, it is effective to make thickness of this substrate thin and to raise optical transmissivity, when raising the luminous efficiency of a light emitting device.

Usually, using what is the thickness not less than 0.01 mm as the substrate for thin film formation, a thin film substrate, or the substrate for light emitting device production etc. is desirable from a point of the handling strength.

Since optical transmissivity will tend to lower if thickness becomes thick, usually it is preferred to use what is the thickness not more than 8.0 mm as the substrate for thin film formation, a thin film substrate, or the substrate for light emitting device production.

In this invention, as for the above-mentioned sintered compact which comprises an aluminum nitride as the main ingredients, it is effective if the substrate for thin film formation, a thin film substrate, or the substrate for light emitting device production etc. has optical permeability in the state where it is actually used in the range whose thickness is at least 0.01 mm-8.0 mm.

That is, even if the thickness of the above-mentioned sintered compact which comprises an aluminum nitride as the main ingredients is the range of at least 0.01 mm-8.0 mm, or except it, optical transmissivity may just be at least not less than 1% in the state where it is actually used, for example, even if the thickness, such as 0.1 mm or 2.0 mm etc., is not actually 0;5 mm necessarily as a substrate for light emitting device production, the luminous efficiency of the produced light emitting device will tend to improve if it has optical permeability and optical transmissivity is at least not less than 1%.

Therefore, the optical transmissivity of the above-mentioned sintered compact which comprises an aluminum nitride as the main ingredients according to this invention is unrelated to the thickness of this sintered compact, and the optical permeability in the condition where this sintered compact is actually used is important, and it means the optical transmissivity in the condition where this sintered compact is actually used.

Optical transmissivity differs from the measurement at the time of the substrate thickness of 0.5 mm when the thickness of the substrate is thinner than 0.5 mm at an actually used condition or is thicker than 0.5 mm, optical transmissivity tends to become high than the measurement at the time of 0.5 mm when thinner than 0.5 mm, it is easy to become lower than the optical transmissivity measured at the time of 0.5 mm when thicker than 0.5 mm.

In this invention, in order to make luminescence from a light emitting device easy to emit not only in the substrate surface side on which this light emitting device was mounted but also in the direction of the substrate surface side opposite to the field where this light emitting device was mounted, it is preferred to use the sintered compact which comprises an aluminum nitride as the main ingredients and has the optical transmissivity not less than 1% in the state where it is actually used as a substrate for light emitting device mounting.

The light emitting device mounted on the substrate for light emitting device mounting according to this invention emits light of the domain where wavelength is comparatively short from ultraviolet light domain to visible light, such as the range of 200 nm-550 nm, as mentioned above.

When using such a light emitting device for the light source for lighting, it comes to feel as white light of a continuous spectrum by man's eyes by the complement relation between this phosphor and this light emitting device by using together the phosphor which comprises YAG (yttrium aluminum Garnett) as the main ingredients and has the excitation spectrum of a wavelength domain longer than the luminescence wavelength of this light emitting device.

As for one of the reasons by which this inventor selected the light with a wavelength of 605 nm as a light for transmissivity measurement, it is because the wavelength of this white light is in the range of about 400 nm-800 nm and light with a wavelength 605 nm is near this center.

In this invention, the sintered compact which comprises an aluminum nitride as the main ingredients and which has optical permeability usually shows permeability to the light with a wavelength not less than 200 nm in many cases.

That is, permeability begins to be shown to the light of the range of 200 nm-250 nm wavelength, permeability goes up rapidly to the light of the range of 250 nm-350 nm wavelength, and there is a tendency to have almost fixed optical transmissivity to the light which is in the boundary domain from ultraviolet light to a visible light domain and has wavelength not less than 350nm -400nm.

As for one of the reasons by which this inventor selected the light with a wavelength of 605 nm as a wavelength for optical transmissivity measurement, it is also because optical transmissivity becomes almost fixed in the range of 400 nm-800 nm wavelength of a visible light domain and light with a wavelength 605 nm is near this center.

Thus, even if it does not use as optical transmissivity the measured value in light other than the wavelength of 605 nm or in continuous spectra, if the optical transmissivity to the light with a wavelength 605 nm is used, it can distinguish on behalf of the quality of the sintered compact according to this invention which comprises an aluminum nitride as the main ingredients and which has optical permeability as a substrate for light emitting device mounting.

In the substrate for light emitting device mounting according to this invention, the sintered compact which comprises an aluminum nitride as the main ingredients also has a function as the support medium or container for mounting a light emitting device at least, and it has not only the shape of a mere board but also the structures, such as the dent space (cavity) and plinth for mounting a light emitting device if needed as form of this substrate for light emitting device mounting, and metallizing, such as metallizing by co-firing, metallizing by thick film baking, or thin film metallizing, are given to a light emitting device mounting portion if needed, a light emitting device is fixed and mounted on the substrate which consists of a sintered compact which comprises an aluminum nitride as the main ingredients by using connection material, such as braze materials (they contain low melting point braze materials, such as Pb—Sn system solder alloy, Au—Si system alloy, Au—Sn system alloy, Au—Ge system alloy, the alloy containing Sn, the alloy containing In, metal Sn, metal In, Pb free solder, or high melting point braze materials, such as silver braze material, etc.), conductive adhesives or electric insulation adhesives etc.

Metallizing which is formed in the above-mentioned light emitting device mounting portion of the sintered compact which comprises an aluminum nitride as the main ingredients also achieves the duty as an electric circuit for connecting with a light emitting device electrically if needed, and supplying an electric signal and electric power to this light emitting device.

It can be used even if it is any connection material other than the above-illustrated connection material, because there is little stress generating at the fixed portion by heating-and-cooling which is generated at the time of heating-and-cooling in fixing and mounting the light emitting device on a substrate or at the time of a light emitting device driving, and the thermal expansion coefficient is close, between the substrate for light emitting device mounting according to this invention which consists of a sintered compact which comprises an aluminum nitride as the main ingredients, and the light emitting device which comprises as the main ingredients at least one or more materials selected from a gallium nitride, an indium nitride, and an aluminum nitride.

When a light emitting device is fixed to the sintered compact which comprises an aluminum nitride as the main ingredients by using adhesives, such as conductive adhesives or electric insulation adhesives, among the above-mentioned connection material, it may not necessarily be what gave metallizing to the light emitting device mounting portion as this sintered compact which comprises an aluminum nitride as the main ingredients.

The above-mentioned sintered compact which comprises an aluminum nitride as the main ingredients possesses electric circuits, such as multilayered metallizing by co-firing, and thick film metallizing or thin film metallizing, and also a conduction via, for making a light emitting device drive if needed.

In the above-mentioned substrate for light emitting device mounting which has a cavity space, there are the method to form cavity space by using the unified sintered compact which comprises an aluminum nitride as the main ingredients, and the method to form cavity space by junction a frame to a plate-like base as the method of forming cavity space.

In this invention, as the above-mentioned substrate for light emitting device mounting which has a cavity space, what is a constitution, such as what formed cavity space by using the unified sintered compact which comprises an aluminum nitride as the main ingredients, or what formed cavity space by joining the frame which consisits of other material, for example, transparent resin, or glass, into a plate-like base, is preferred.

By the above-mentioned constitution, the substrate for light emitting device mounting according to this invention not only becomes easier to emit luminescence from a light emitting device into outside but also improves a nature of radiating heat, an electric circuit can be designed more compactly, and it can mount a large-sized light emitting device.

In the above-mentioned substrate for light emitting device mounting in which cavity space was formed by joining a frame to a plate-like base, a light emitting device is usually mounted on the above-mentioned plate-like base.

In this invention, in the above-mentioned substrate for light emitting device mounting which has cavity space, in that whose cavity space was formed by junction between a plate-like base and a frame, either a plate-like base or a frame consists of a sintered compact which comprises an aluminum nitride as the main ingredients, or both a plate-like base and a frame consist of a sintered compact which comprises an aluminum nitride as the main ingredients.

In the above-mentioned plate-like base or frame, electric circuits for making a light emitting device drive, such as multilayered metallizing, thick film metallizing, thin film metallizing, and a conduction via, are possessed if needed.

As the above-mentioned material of the plate-like base or frame, it can be used if needed, for example, various metal, various resin, various glass, and various ceramics, etc., other than the sintered compact which comprises an aluminum nitride as the main ingredients.

The lid for sealing the light emitting device mounted in cavity space if needed is formed in the above-mentioned substrate for light emitting device mounting according to this invention which has cavity space.

As for seal by using this lid, both the hermetic seal which used metal, an alloy, and glass for the sealing agent, and the non-hermetic seal which used resin etc. for a sealing agent can be performed.

For example, various metal, various resin, various glass, various ceramics, etc. can be used as a material of this lid.

Luminescence from a light emitting device can be efficiently emitted to the substrate exterior using the sintered compact according to this invention which has optical permeability and which comprises an aluminum nitride as the main ingredients, other transparent resin, glass, or ceramics etc. as a lid.

The substrate for light emitting device mounting according to this invention also contains what used the sintered compact which comprises an aluminum nitride as the main ingredients and which has optical permeability as a lid as mentioned above.

The light emitting device mounted or contained by the substrate for light emitting device mounting according to this invention has structure as shown in FIGS. 69 or FIG. 70.

FIG. 69 shows the section structure of a light emitting device in which the thin film layer 2 which comprises as the main ingredients at least one or more materials selected from a gallium nitride, an indium nitride, and an aluminum nitride, grew epitaxially by methods, such as MOCVD, on the substrates 1 for light emitting device production of electric insulation, such as sapphire or an aluminum nitride, and was formed furthermore into N type semiconductor by doping agents, such as Si, is formed, further the epitaxially grown luminescence layer 3 which comprises as the main ingredients at least one or more materials selected from a gallium nitride, an indium nitride, and an aluminum nitride and consists of single quantum well structure and multi-quantum-well structure, etc., for example, is formed, further the epitaxially grown thin film layer layer 4 which comprises as the main ingredients at least one or more materials selected from a gallium nitride, an indium nitride, and an aluminum nitride and was formed into P type semiconductor by doping agents, such as Mg etc., is formed, and the external electrodes 5 and 6 are being formed on N type semiconductor thin film layer and P type semiconductor thin film layer, respectively.

In the light emitting device shown in FIG. 69, the thin film layer 2 can be formed also as a P type semiconductor layer, and the thin film layer 4 is formed as an N type semiconductor layer in that case.

As shown in FIG. 69, when what is electric insulation is used as a substrate for producing a light emitting device, the external electrodes 5 and 6 are usually arranged at the surface side in which the device is being formed.

FIG. 70 shows the section structure of a light emitting device in which the N type semiconductor thin film layer 2 which grew epitaxially by methods, such as MOCVD, on the substrate 10 for light emitting device production which has conductivity, such as a silicon carbide single crystal or a gallium nitride single crystal is formed by doping agents, such as Si, to the main ingredients which consist of at least one or more materials selected from a gallium nitride, an indium nitride, and an aluminum nitride, further the above-mentioned luminescence layer 3 which has the quantum well structure which comprises as the main ingredients at least one or more materials selected from a gallium nitride, an indium nitride, and an aluminum nitride is formed, further P type semiconductor thin film layer 4 is formed by doping agents, such as Mg, to the main ingredients which consist of at least one or more materials selected from a gallium nitride, an indium nitride, and an aluminum nitride, the external electrodes 5 and 6 are being formed on N type semiconductor thin film layer and P type semiconductor thin film layer, respectively.

In the light emitting device shown in FIG. 70, the thin film layer 2 can be formed also as a P type semiconductor layer, and the thin film layer 4 is formed as an N type semiconductor layer in that case.

As shown in FIG. 70, when a conductive thing is used as a substrate for producing a light emitting device, usually, an electrode 5 can be formed on the surface which is the opposite side of the surface where the device is being formed in the substrate 10 for forming a light emitting device, and another electrode 6 can be arranged to the surface side on which the device is being formed.

The substrate 10 of FIG. 70 includes not only material which has conductivity originally, such as a silicon carbide single crystal and a gallium nitride single crystal but also what can electrically connect the surface of this substrate in which the light emitting device is formed and the opposite surface by forming a conduction via in the inside of the substrate for forming a light emitting device even if it is the material of electric insulation, such as aluminum nitride etc.

In FIGS. 69 and FIG. 70, the thin film buffer layer which comprises as the main ingredients at least one or more materials selected from a gallium nitride, an indium nitride, and an aluminum nitride is usually formed between a substrate 1 or a substrate 10, and the thin film layer 2 of epitaxially grown N type (or P type) semiconductor.

A buffer layer is usually formed at low temperature, and has crystallized states, such as an amorphous state, a polycrystal, or an orientated polycrystal etc., in many cases.

Thus, “The light emitting device which comprises as the main ingredients at least one or more materials selected from a gallium nitride, an indium nitride, and an aluminum nitride” said in this invention, is constituted by making into N type semiconductor layer, luminescence layer, and P type semiconductor layer the epitaxially grown thin film which comprises as the main ingredients at least one or more materials selected from a gallium nitride, an indium nitride, and an aluminum nitride on substrates, such as sapphire, as mentioned above, and laminating these, light is emitted from a luminescence layer by applying direct-current potential to electrodes.

For example, light can be emitted over the wide wavelength range from an ultraviolet-rays domain to a visible light domain by adjusting composition of this luminescence layer etc.

Speaking concretely, it can emit the light of the wavelength range of 250 nm-650 nm, for example, it is usually produced in many cases so that the light of the wavelength range of 300 nm-600 nm may be emitted.

The above-mentioned light emitting device is beginning to be widely used as a light emitting diode (LED) or a laser diode (LD).

As for the above-mentioned substrate used for producing the light emitting device constituted by the epitaxially grown thin film which comprises as the main ingredients at least one or more materials selected from a gallium nitrides, an indium nitride, and an aluminum nitride, this inventor has proposed in JP application for patent 2002-362783, and JP application for patent 2003-186175 etc. that the sintered compact which comprises an aluminum nitride as the main ingredients, or the sintered compact which comprises as the main ingredients a ceramic material which has at least one of the crystal structures selected from a hexagonal system or a trigonal system, such-as a silicon carbide, a silicon nitride, a zinc oxide, a beryllium oxide, an aluminum oxide etc., and furthermore the sintered compact which comprises a ceramic material as the main ingredients and which has optical permeability, such as a zirconium dioxide, a magnesium oxide, a magnesium aluminate, a titanium oxide, a barium titanate, a lead titanate zirconate, rare earth oxides such as a yttrium oxide, a thorium dioxide, various ferrites, a mullite, a forsterite, a steatite, and glass ceramics etc., can produce the light emitting device which has equivalent luminous efficiency at least or is a maximum of not less than 4-5 times than conventionally used single crystals, such as sapphire.

Although the luminous efficiency of the light emitting device produced using the conventional substrates, such as sapphire, is about 2%-8%, on the other hand, if it is the light emitting device produced using as a substrate the above-mentioned various sintered compacts which comprise a ceramic material as the main ingredients, it can also produce what is equivalent 8% luminous efficiency at least and what is a maximum of not less than 4-5 times, and the light emitting device which has luminous efficiency not less than 50% is also producible.

The light emitting device which has such high luminous efficiency that this inventor proposed can also be mounted on the substrate for light emitting device mounting by invention satisfactory.

The light emitting device of the structure illustrated at least in FIGS. 69 and FIG. 70 emits light with a wavelength range of not more than 800 nm wavelength, such as the wavelength not more than 600 nm and further a wavelength not more than 550 nm of green light—up to the wavelength 200 nm of ultraviolet light, from a luminescence layer, the light of the above-mentioned wavelength range is usually emitted in all the directions from the luminescence layer of this light emitting device.

The substrate for light emitting device mounting according to this invention is for mounting or containing such a light emitting device.

The sintered compact which only comprises an aluminum nitride as the main ingredients as a material of the substrate for light emitting device mounting according to this invention is not just enough.

Also it excels most in various ceramics as a substrate material, since as for the sintered compact which comprises an aluminum nitride as the main ingredients, originally, it has high thermal conductivity, and has electric insulation, and the thermal expansion coefficient is almost the same as the gallium nitride, the indium nitride, and the aluminum nitride which are the main ingredients of a light emitting device, it is suitable to radiate efficiently generation of heat from this light emitting device to the substrate exterior, a compact circuit substrate design is possible using multilayered metallizing and thin film metallizing, etc., it also bears against thermal shock which accompanies the drive of a light emitting device, and it is possible to mount and contain a large-sized light emitting device further.

Thus, although the sintered compact which comprises an aluminum nitride as the main ingredients has the characteristic good as a substrate material as mentioned above, it is not enough as a substrate for light emitting device mounting.

That is, it is important that luminescence from this light emitting device is efficiently emitted to the exterior of a substrate as a substrate in which a light emitting device is mounted, and however the sintered compact which comprises an aluminum nitride as the main ingredients as a substrate material may be excellent in other fields, if luminescence from the light emitting device to the substrate exterior cannot be emitted efficiently, as a substrate in which a light emitting device is mounted, it is not enough.

Luminescence from a light emitting device is usually emitted into all directions.

The substrate for mounting and containing a light emitting device conventionally mainly used metal material, such as the above-mentioned aluminum which carried out alumite covering and insulation-ized the surface.

Therefore, in the substrate for mounting or containing a light emitting device, luminescence of a light emitting device is emitted to the exterior of a substrate comparatively efficiently from the surface side where the light emitting device is mounted or contained, by raising the reflectance of a light emitting device mounting portion, or by devising the form of this mounting portion.

On the other hand, since luminescence from a light emitting device is hard to be transmitted by penetrating a substrate, luminescence from a light emitting device is not efficiently emitted to the substrate exterior from the surface which is the opposite side of the surface where the light emitting device is mounted or contained.

Therefore, in a conventional substrate, if it sees on the whole, it will be hard to say that luminescence from a light emitting device is not necessarily efficiently emitted to the substrate exterior.

If luminescence from a light emitting device is not similarly emitted to the substrate exterior efficiently in the sintered compact which comprises an aluminum nitride as the main ingredients, it cannot be said that it is enough as a substrate for mounting or containing a light emitting device.

In this invention, when the sintered compact which comprises an aluminum nitride as the main ingredients and which has optical permeability is used as a substrate for light emitting device mounting, luminescence from a light emitting device penetrates a substrate and becomes easy to be emitted into outside, and it becomes possible to emit to the substrate exterior efficiently.

This invention also provides the substrate for light emitting device mounting which can emit luminescence from a light emitting device into the arbitrary direction of the space of the circumference of a substrate containing the surface of a substrate where the light emitting device is mounted or contained and the opposite surface and consists of a sintered compact which comprises an aluminum nitride as the main ingredients.

As mentioned above, that luminescence from a light emitting device can be emitted into the arbitrary direction of the space of the circumference of a substrate means that luminescence from a light emitting device can emit in nearly equal intensity into all the space of the circumference of a substrate, or that it is emitted into all the space of the circumference of a substrate and it can be emitted more strongly into the space of a specific direction, or that it is not emitted into all the space of the circumference of a substrate but can be emitted more strongly into the space of a specific direction, or that it can be emitted only into the space of the specific direction of the substrate circumference, for example.

This invention also provides the substrate for optical device mounting which can control the direction of luminescence from a light emitting device in this way.

Therefore, as for this invention, it is effective to use what has optical permeability as a sintered compact which comprises an aluminum nitride as the main ingredients as a material which constitutes a substrate.

By using the sintered compact which comprises an aluminum nitride as the main ingredients and which has optical permeability, it is transmitted so that luminescence from a light emitting device may penetrate a substrate, and it is improvable so that luminescence from a light emitting device may be efficiently emitted to the substrate exterior not only from the surface side where the light emitting device is mounted or contained but also from the opposite side of the surface where the light emitting device is mounted or contained.

In this invention, what combined the reflective prevention material or the reflective material with the sintered compact which comprises an aluminum nitride as the main ingredients is effective as the substrate for optical device mounting which can control the direction of luminescence from a light emitting device.

Direction control of luminescence from a light emitting device can be performed now comparatively easily by using combining the reflective prevention material, or the reflective material, and the sintered compact which comprises an aluminum nitride as the main ingredients.

The sintered compact which comprises an aluminum nitride as the main ingredients and which combines with the above-mentioned reflective prevention material or a reflective material can perform now direction control of luminescence from a light emitting device more easily and certainly by using what has optical permeability.

Even if the above-mentioned reflective prevention material or a reflective material forms in the sintered compact which comprises an aluminum nitride as the main ingredients and whose optical transmissivity is smaller than 1% or does not have optical permeability substantially, it may generate the reflective prevention function and a reflective function.

As for the sintered compact which comprises an aluminum nitride as the main ingredients and is used as a substrate for light emitting device mounting according to this invention which can emit luminescence from a light emitting device into the arbitrary direction of the space of the circumference of a substrate, if it is used combining a reflective prevention material, a reflective material, etc. as mentioned above, the function may be shown even if it does not necessarily have optical permeability, but it is desirable to use what has optical permeability if possible and what has high optical transmissivity if needed, in order to perform easy control of the luminescence direction from a light emitting device and to raise the efficiency of emitting this luminescence into the substrate exterior.

The sintered compact which comprises an aluminum nitride as the main ingredients and is used for the substrate for light emitting device mounting according to this invention has optical permeability.

However, about the optical permeability of the sintered compact according to this invention which comprises an aluminum nitride as the main ingredients and the optical permeability of material, such as glass and resin, the quality differs.

That is, for example, even if optical transmissivity is the same as 80%, although the irradiated light penetrates linearly in material, such as glass and resin, in the case of the sintered compact according to this invention which comprises an aluminum nitride as the main ingredients it is rare that the irradiated light is penetrated linearly in the inside of this sintered compact, and most is penetrated being scattered about, eventually, the total amount of the light penetrated becomes same as glass or resin material.

It seems that a difference arises in the feeling of the visual touch of the light penetrated by the eyes of the human being when the routes of an optical penetration differed, even if it is the material of the same optical transmissivity.

That is, the light from a light emitting device is easy to be felt by man's eyes as shiny light which pierces an eye by penetrating linearly transparent resin, clear glass, etc., on the other hand in the case of the sintered compact which comprises an aluminum nitride as the main ingredients, it is considered that it is easy to be felt by man's eyes as a gentle light compared with glass or resin material because it is penetrated being scattered about.

The mimetic diagram of FIGS. 96 and FIG. 97 showed this situation.

It is the mimetic diagram showing the situation of the optical penetration when using the material which light, such as glass or resin which have optical permeability, penetrates linearly in FIG. 96.

In FIG. 96, the light 111 from a light emitting device is irradiated to the material 110, such as glass or resin which have optical permeability, then it becomes the penetration light 112 linearly and penetrates.

FIG. 97 is the mimetic diagram showing a situation in case light penetrates the sintered compact which comprises an aluminum nitride as the main ingredients and which has optical permeability.

In FIG. 97, the light 121 from a light emitting device is irradiated to the sintered compact 120 which comprises an aluminum nitride as the main ingredients and which has optical permeability, then it becomes a scattered light 122 and penetrates.

Even if what was colored, such as black, gray-black, gray, is used as the above-mentioned sintered compact which comprises an aluminum nitride as the main ingredients, it becomes easy to feel luminescence from the light emitting device which penetrated this sintered compact as gentle light by man's eyes.

Luminescence from the light emitting device which penetrated the sintered compacts which comprise an aluminum nitride as the main ingredients and are colored into black, gray-black, and gray etc. is easy to be felt by man's eyes as a gentle light of a different optical tone compared with the light which penetrated the sintered compact which comprises an aluminum nitride as the main ingredients and is not colored into black, gray-black, gray etc.

The meaning called a different optical tone is that feeling of the light which is felt by the eye differs, if the color tones of the sintered compact which comprises an aluminum nitride as the main ingredients differ, since the factors, such as the degree of brightness of light, the degree of gentleness, and the color tone etc. which penetrate a sintered compact differ little by little as a result, it is considered that feeling of luminescence from a light emitting device by an actual eye is delicately different.

What contains ingredients, such as Mo, W, V, Nb, Ta, Ti, and carbon, in order to achieve black-ization as the above-mentioned sintered compact which comprises an aluminum nitride as the main ingredients and is colored, such as the black, gray-black, and gray, is used.

What contains ingredients, such as other transition metals, for example, iron, nickel, chromium, manganese, zirconium, hafnium, cobalt, copper, and zinc, as a sintered compact which comprises an aluminum nitride as the main ingredients and is colored, such as black, gray-black, and gray, is also used.

As ingredients, such as Mo, W, V, Nb, Ta, Ti, carbon, iron, nickel, chromium, manganese, zirconium, hafnium, cobalt, copper, and zinc which are used in order to obtain the above-mentioned sintered compact which comprises an aluminum nitride as the main ingredients and is colored, such as black, gray-black, and gray, they may be what was added intentionally when manufacturing this sintered compact which comprises an aluminum nitride as the main ingredients or they may be what was mixed as unescapable impurities of the raw material for sintered compact production etc.

In the substrate for light emitting device mounting according to this invention which consists of a sintered compact which comprises an aluminum nitride as the main ingredients and which has optical permeability, once luminescence from a light emitting device penetrates the inside of this sintered compact which comprises an aluminum nitride as the main ingredients, it is emitted to the substrate exterior in many cases.

The above-mentioned sintered compact which comprises an aluminum nitride as the main ingredients is a polycrystalline substance which consists of a fine crystal of an aluminum nitride.

Therefore, since luminescence from a light emitting device tends to become a scattered light in a sintered compact in case it penetrates the inside of this sintered compact which comprises an aluminum nitride as the main ingredients, luminescence from this light emitting device emitted to the substrate exterior is not a direct light emitted from a light emitting device but has all directions, unlike shiny light which has penetrated transparent resin, clear glass, etc. linearly and pierces an eye, it tends to become into a gentle light.

Therefore, if the light emitting device mounted on the substrate for light emitting device mounting according to this invention as a light source of common lighting is used, a light source which is gentle to man's eye and is gentle will be easy to be obtained.

Even if the electric circuit is provided into the inside of a sintered compact or on the sintered compact surface by metallizing which is formed on the surface of the substrate for light emitting device mounting according to this invention by co-firing etc. using tungsten, molybdenum, or copper etc. as the main ingredients, or by thick film metallizing which prints and forms later on the sintered compact which comprises an aluminum nitride as the main ingredients which once fires and is obtained, or by thin film metallizing by sputterig, vapor deposition, or ion-plating, since the substrate for light emitting device mounting according to this invention is the sintered compact which comprises an aluminum nitride as the main ingredients, luminescence from a light emitting device tends to become a scattered light as mentioned above, the light emitted from this light emitting device has little loss from the electric circuit which is being formed and it may be emitted to the substrate exterior efficiently as a light which penetrated this substrate for light emitting device mounting.

That is, luminescence from the light emitting device which penetrates the inside of a substrate and is emitted to the exterior cannot produce easily the reduction of the brightness by the shadow of the electric circuit which is being formed on the sintered compact surface etc.

The substrate for light emitting device mounting according to this invention can also use the thing in which an electric circuit of single layer or multilayer metallizing or conduction via are being formed using tungsten, molybdenum, or copper for the main ingredients not only at the surface of a substrate but also in the inside of the substrate which comprises an aluminum nitride as the main ingredients.

Thus, since the sintered compact which comprises an aluminum nitride as the main ingredients and which has optical permeability is used as a substrate for light emitting device mounting according to this invention, luminescence from a light emitting device tends to become a scattered light, the light emitted from this light emitting device has little loss from the electric circuit or the conduction via which are being formed and it penetrates a substrate and may be efficiently emitted to the substrate exterior.

That is, as for the luminescence from the light emitting device which penetrates the inside of a substrate and is emitted to the exterior, it is hard to produce reduction of the brightness by the shadow of the electric circuit and conduction via etc. which are being formed in the inside of a sintered compact.

As mentioned above, the substrate for light emitting device mounting according to this invention can also use that whose electric circuit by single layer or multilayer metallizing or conduction via are being formed not only on the surface of a substrate but also in the inside of the substrate which comprises an aluminum nitride as the main ingredients by co-firing using a conductive material which comprises tungsten, molybdenum, or copper as the main ingredients.

The substrate for light emitting device mounting according to this invention can also use the thing whose electric circuit is formed at the surface of a substrate and whose electric circuit is also simultaneously being formed also in the inside of a substrate.

Thus, even if it is the thing whose electric circuit is formed at the surface of a substrate and whose electric circuit is also being formed simultaneously in the inside of a substrate, if the sintered compact which comprises an aluminum nitride as the main ingredients and which has optical permeability is used as a substrate for light emitting device mounting according to this invention, since luminescence from a light emitting device tends to become a scattered light, the light emitted from this light emitting device has little loss from the electric circuit or the conduction via which are being formed and it may be efficiently emitted to the substrate exterior as the light which penetrated the substrate.

That is, as for the luminescence from the light emitting device which penetrates the inside of a substrate and is emitted to the exterior, it is hard to produce reduction of the brightness by the shadow of the electric circuit and conduction via etc. which are being formed in the inside of a sintered compact or the sintered compact surface.

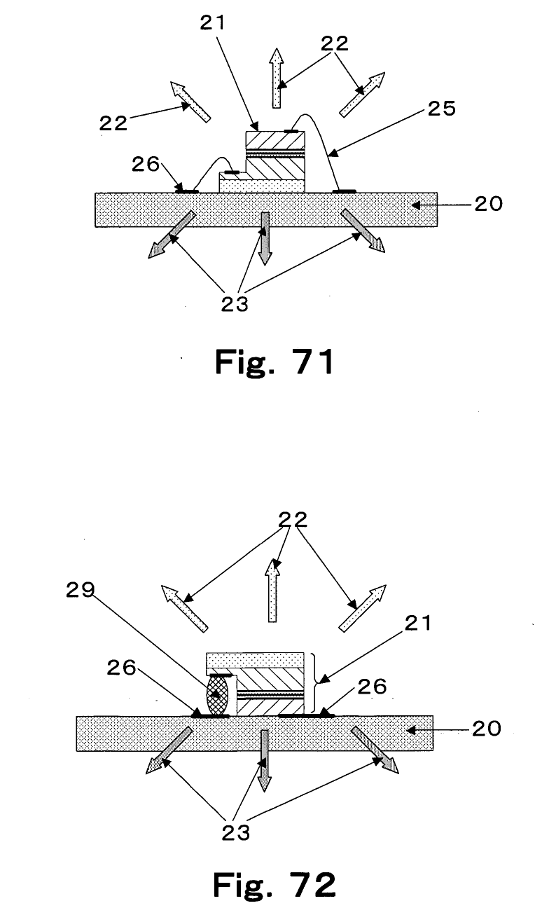

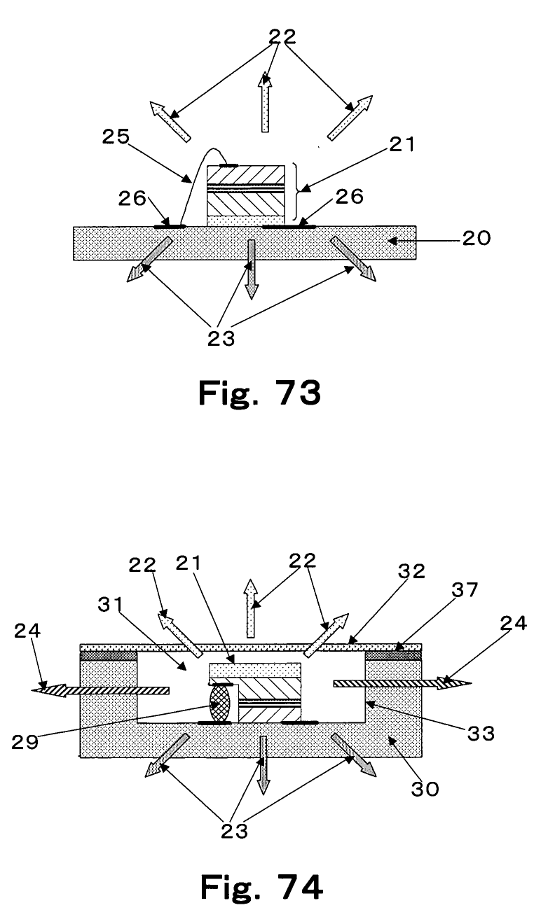

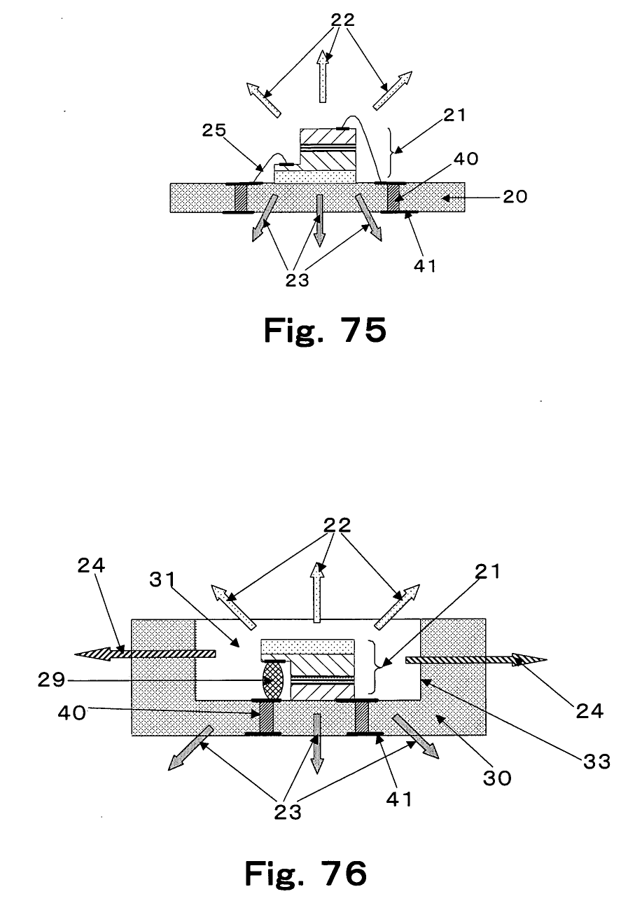

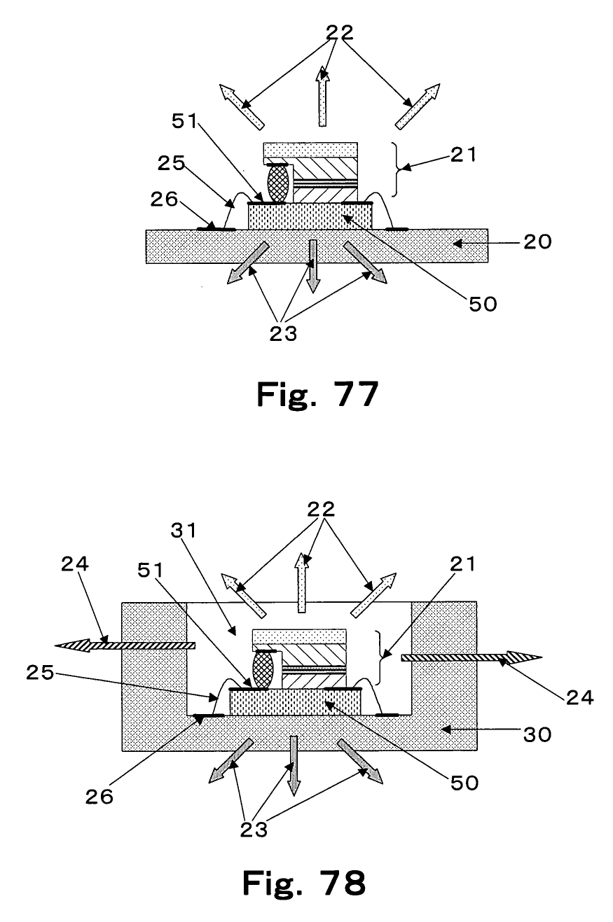

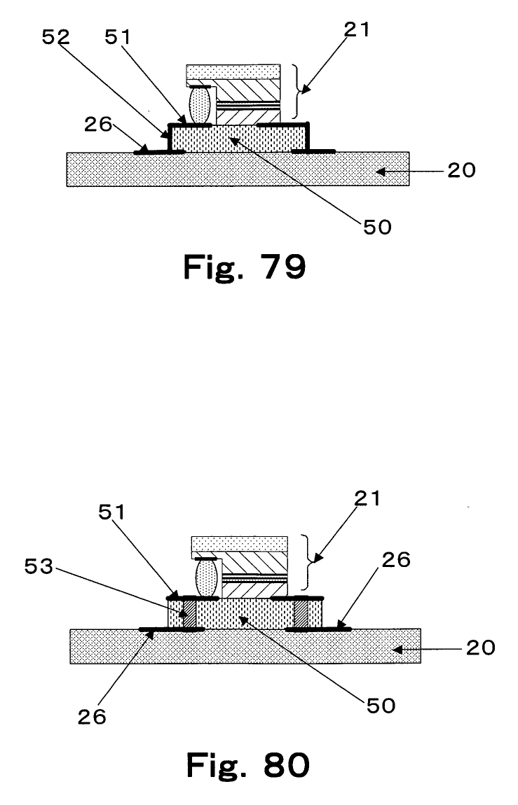

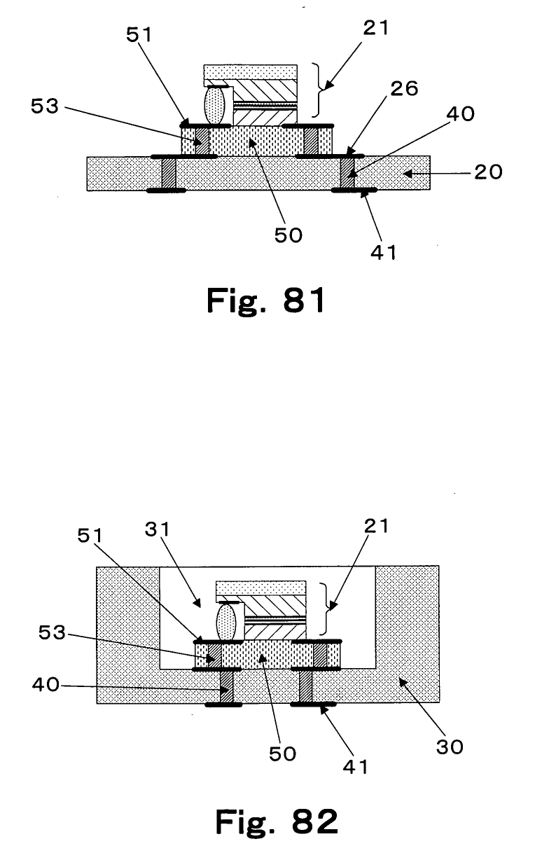

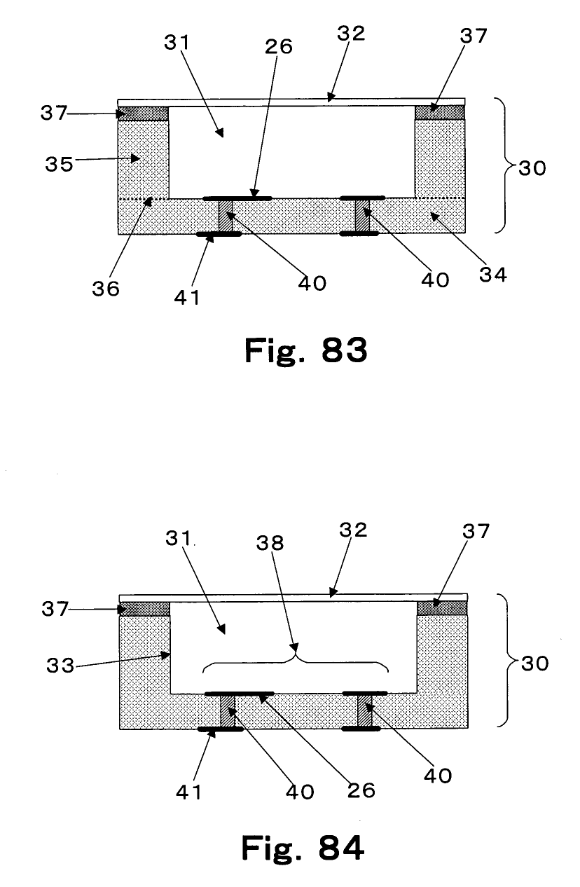

FIG. 71, FIG. 72, FIG. 73, FIG. 74, FIG. 75, FIG. 76, FIG. 77, FIG. 78, FIG. 79, FIG. 80, FIG. 81, FIG. 82, FIG. 83, FIGS. 84, FIG. 100, and FIG. 101 are the sectional views which illustrated the substrate for light emitting device mounting according to this invention which consists of a sintered compact which comprises an aluminum nitride as the main ingredients.

In this invention, as for the sintered compact which comprises an aluminum nitride as the main ingredients and is used as a substrate for light emitting device mounting, what has optical permeability is preferred.

In each above-mentioned figure, at least FIG. 71, FIG. 72, FIG. 73, FIG. 74, FIG. 75, FIG. 76, FIG. 77, and FIG. 78 are drawn as that whose sintered compact which comprises an aluminum nitride as the main ingredients and is used as a substrate for light emitting device mounting has optical permeability.

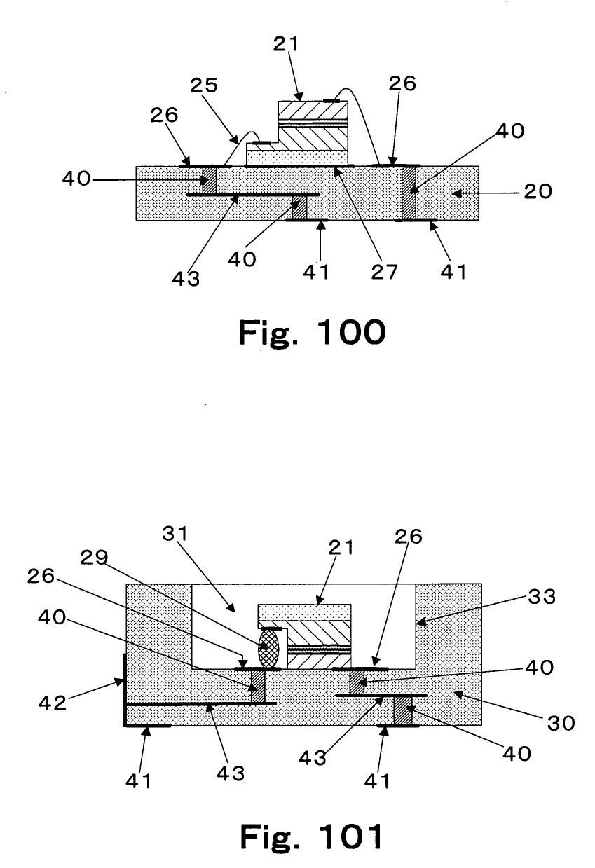

FIGS. 100 and FIG. 101 are sectional views which illustrated the substrate for light emitting device mounting which is produced by using the sintered compact which comprises an aluminum nitride as the main ingredients and formed the electric circuit in the inside.

A light emitting device is sealed in this sealing agent by using sealing agents, such as transparent resin, if needed.

When using the plate-like substrate for light emitting device mounting which does not have especially cavity space, as for the light emitting device mounted, it is preferred to be used in the state where it was sealed in the above-mentioned sealing agent.

In FIG. 71, the light emitting device 21 is mounted on the substrate for light emitting device mounting 20 according to this invention which consists of the sintered compact which comprises an aluminum nitride as the main ingredients, and it connects electrically by wire 25 with the surface electric circuit 26 by metallizing by co-firing, thick film metallizing or thin film metallizing which are being formed on the light emitting device mounting side of a substrate 20.

In the surface on which the light emitting device of a substrate 20 is mounted, the luminescence 22 from a light emitting device 21 is emitted to the substrate exterior without almost interrupting.

Also in the opposite side of the surface on which the light emitting device is mounted, the light emitted from the light emitting device 21 is emitted to the substrate exterior as a light 23 which penetrated the substrate 20.

Thus, even if the electric circuit is provided to the substrate for light emitting device mounting by metallizing by co-firing, thick film metallizing, or thin film metallizing etc., since the substrate for light emitting device mounting according to this invention is the sintered compact which comprises an aluminum nitride as the main ingredients and luminescence from a light emitting device tends to become a scattered light, the light emitted from this light emitting device has little loss from the electric circuit which is being formed and it may be emitted to the substrate exterior efficiently as a light 23 which penetrated the substrate 20.

The substrate for light emitting device mounting according to this invention can also use the thing in which the electric circuit by single layer or multilayer metallizing or the conduction via are being formed not only on the surface of a substrate but also in the inside of the substrate which comprises an aluminum nitride as the main ingredients by co-firing etc. using tungsten, molybdenum or copper etc. as the main ingredients.

Thus, even if the electric circuit is formed in the inside of a substrate, since the substrate for light emitting device mounting according to this invention is the sintered compact which comprises an aluminum nitride as the main ingredients and luminescence from a light emitting device tends become a scattered light, the light emitted from this light emitting device has little loss from the electric circuit or the conduction via which are being formed and it may be emitted to the substrate exterior efficiently as a light 23 which penetrated the substrate 20.

In FIG. 71, the light emitting device 21 illustrated the thing of the structure shown in FIG. 69.

In FIG. 72, what is the structure shown in FIG. 69 is being illustrated as the light emitting device 21.

The light emitting device 21 is mounted on the substrate for light emitting device mounting 20 which consists of a sintered compact which comprises an aluminum nitride as the main ingredients where up-and-down reversal state is performed from the state which showed in FIG. 69.

In FIG. 72, among the external electrodes which is being formed in the light emitting device 21, what is connected to N type semiconductor layer is fixed with the surface electric circuit 26 by metallizing by co-firing, thick film metallizing or thin film metallizing which are being formed on the light emitting device mounting side of a substrate 20 by the connection material 29 of the shape of a non-wire, such as low melting point braze material and conductive adhesive, and is also connected electrically.

Furthermore, the external electrode connected to P type semiconductor layer of this light emitting device 21 is fixed with the surface electric circuit 26 by metallizing by co-firing, thick film metallizing or thin film metallizing which are being formed on the light emitting device mounting side of a substrate 20 by the connection material of the shape of a non-wire (it is not shown in a figure), such as low melting point braze material and conductive adhesive, and is also connected electrically.

In the surface side of the substrate 20 on which the light emitting device is mounted, the luminescence 22 from this light emitting device is emitted to the substrate exterior, without almost interrupting.

Also in the opposite side of the surface on which the light emitting device is mounted, the light emitted from the light emitting device is emitted to the substrate exterior as a light 23 which penetrated the substrate 20.

Thus, even if the electric circuit is provided to the substrate for light emitting device mounting by metallizing by co-firing, thick film metallizing or thin film metallizing etc., since the substrate for light emitting device mounting according to this invention is the sintered compact which comprises an aluminum nitride as the main ingredients and luminescence from a light emitting device tends to become a scattered light, the light emitted from this light emitting device has little loss from the electric circuit which is being formed and it may be emitted to the substrate exterior efficiently as a light 23 which penetrated the substrate 20.

The substrate for light emitting device mounting according to this invention can also use the thing in which the electric circuit by single layer or multilayer metallizing or the conduction via are being formed not only on the surface of a substrate but also in the inside of the substrate which comprises an aluminum nitride as the main ingredients by co-firing etc. using tungsten, molybdenum or copper etc. as the main ingredients.

Thus, even if the electric circuit is being formed in the inside of a substrate, since the substrate for light emitting device mounting according to this invention is the sintered compact which comprises an aluminum nitride as the main ingredients and luminescence from a light emitting device tends to become a scattered light, the light emitted from this light emitting device has little loss from the electric circuit or the conduction via which are being formed and it may be emitted to the substrate exterior efficiently as a light 23 which penetrated the substrate 20.

In FIG. 72, the light emitting device 21 illustrated the thing of the structure shown in FIG. 69.

In FIG. 73, what is the structure shown in FIG. 70 is being illustrated as the light emitting device 21.

In FIG. 73, the light emitting device 21 is mounted on the substrate for light emitting device mounting 20 which consists of a sintered compact according to this invention which comprises an aluminum nitride as the main ingredients, and the external electrode is connected to N type semiconductor layer of a light emitting device 21 is fixed with the surface electric circuit 26 by metallizing by co-firing, thick film metallizing or thin film metallizing which are being formed on the light emitting device mounting side of a substrate 20 by the connection material of the shape of a non-wire (it is not shown in a figure), such as low melting point braze material and conductive adhesive, and is also connected electrically, the another P type external electrode connected to the semiconductor layer is connected electrically with the surface electric circuit 26 by metallizing by co-firing, thick film metallizing or thin film metallizing which are being formed on the light emitting device mounting side of a substrate 20 by the wire 25.

In the surface side on which the light emitting device of a substrate 20 is mounted, the luminescence 22 from this light emitting device is emitted to the substrate exterior without almost interrupting.

In the opposite side of the surface on which the light emitting device is mounted, the light emitted from the light emitting device is emitted to the substrate exterior as a light 23 which penetrated the substrate 20.

Thus, even if the electric circuit is provided to the substrate for light emitting device mounting by metallizing by co-firing, thick film metallizing or thin film metallizing etc., since the substrate for light emitting device mounting according to this invention is the sintered compact which comprises an aluminum nitride as the main ingredients and luminescence from a light emitting device tends to become a scattered light, the light emitted from this light emitting device has little loss from the electric circuit which is being formed and it may be emitted to the substrate exterior efficiently as a light 23 which penetrated the substrate 20.

The substrate for light emitting device mounting according to this invention can also use the thing in which the electric circuit by single layer or multilayer metallizing or the conduction via are being formed not only on the surface of a substrate but also in the inside of the substrate which comprises an aluminum nitride as the main ingredients by co-firing etc. using tungsten, molybdenum or copper etc. as the main ingredients.

Thus, even if the electric circuit is being formed in the inside of a substrate, since the substrate for light emitting device mounting according to this invention is the sintered compact which comprises an aluminum nitride as the main ingredients and luminescence from a light emitting device tends to become a scattered light, the light emitted from this light emitting device has little loss from the electric circuit or the conduction via which are being formed and it may be emitted to the substrate exterior efficiently as a light 23 which penetrated the substrate 20.

In FIG. 74, what is the structure shown in FIG. 69 is being illustrated as the light emitting device 21.

Substrate for light emitting device mounting has cavity space.

The light emitting device 21 is mounted on the substrate for light emitting device mounting 30, where the state of up-and-down reversal is performed from the state which showed in FIG. 69.

The mounting state of the light emitting device in FIG. 74 is the same as the mounting state shown in FIG. 72.

In FIG. 74, the substrate for light emitting device mounting 30 according to this invention which consists of a sintered compact which comprises an aluminum nitride as the main ingredients has the cavity space (cavity) 31 for containing a light emitting device.

The light emitting device 21 is mounted in cavity space 31, what is connected to N type semiconductor layer among the external electrodes which are being formed in this light emitting device 21 is electrically connected with the electric circuit 26 by metallizing by co-firing, thick film metallizing or thin film metallizing etc. which are being formed on the light emitting device mounting side of a substrate 20 by the connection material 29 of the shape of a non-wire, such as low melting point braze material and conductive adhesive etc.

The external electrode connected to P type semiconductor layer of this light emitting device 21 is electrically connected with the surface electric circuit 26 by metallizing by co-firing, thick film metallizing or thin film metallizing etc. which are being formed on the light emitting device mounting side of a substrate 20 by the connection material of the shape of a non-wire (not shown in a figure), such as low melting point braze material and conductive adhesive etc.

In the surface side in which the light emitting device of a substrate 30 is mounted, the lid 32 is attached to the substrate for light emitting device mounting 30 in the seal part 37 by the sealing material, such as solder, braze material, glass, and resin etc., if needed, in order to seal the light emitting device which is mounted in cavity space 31.

The luminescence 22 from this light emitting device is emitted to the substrate exterior without absorbing almost substantially by using as a lid 32 the sintered compact which comprise an aluminum nitride as the main ingredients and which has optical permeability and the transparent material of glass and resin or ceramics.

Also in the opposite side of the surface on which the light emitting device is mounted, the light emitted from the light emitting device is emitted to the substrate exterior as a light 23 which penetrated the substrate 30.

Furthermore, the light emitted from the light emitting device is also emitted to the substrate exterior from the side wall 33 of cavity space 31 as a light 24 which penetrated the substrate.

Thus, even if the electric circuit is provided to the substrate which has cavity space by metallizing by co-firing, thick film metallizing or thin film metallizing etc, since the substrate for light emitting device mounting according to this invention is the sintered compact which comprises an aluminum nitride as the main ingredients and luminescence from a light emitting device tends to become a scattered light, the light emitted from this light emitting device has little loss from the electric circuit which is being formed and it may be emitted to the substrate exterior efficiently as a light 23 which penetrated the substrate 30.

The substrate for light emitting device mounting according to this invention can also use the thing in which the electric circuit by single layer or multilayer metallizing or the conduction via are being formed not only on the surface of a substrate but also in the inside of the substrate which comprises an aluminum nitride as the main ingredients by co-firing etc. using tungsten, molybdenum or copper etc. as the main ingredients.

Thus, since the substrate for light emitting device mounting according to this invention is the sintered compact which comprises an aluminum nitride as the main ingredients and luminescence from a light emitting device tends to become a scattered light even if the electric circuit is formed in the inside of a substrate, the light emitted from this light emitting device has little loss from the electric circuit which is being formed and it may be emitted to the substrate exterior efficiently as a light 23 which penetrated the substrate 30.

In this invention, also when the substrate for light emitting device mounting has the cavity space as shown in FIG. 74, what is the structure shown in FIG. 70 as a light emitting device can also be mounted.

It can mount on the substrate for light emitting device mounting according to this invention also by the method which uses a wire as shown in FIGS. 71 or FIG. 73 as a mounting state of a light emitting device.

In FIG. 74, the lid 32 formed in order to seal the cavity space portion 31 hermetically is not necessarily required, it can be used as a substrate for light emitting device mounting of this invention also in the state where there is no lid 32, in order to emit luminescence from a light emitting device to the substrate exterior without loss.

When not forming a lid 32, luminescence from a light emitting device is emitted to the substrate exterior, without completely being absorbed.

If it is for emitting luminescence from a light emitting device to the substrate exterior without loss, there will be necessarily no necessity of forming a lid 32 using the material of transparent optical permeability.

When not forming a lid, seal of a light emitting device is possible also for filling up the portion of the cavity space portion 31 in FIG. 74 with the resin of optical permeability (it not displaying on FIG. 74), and it can emit luminescence from a light emitting device to the substrate exterior efficiently.

Luminescence from a light emitting device is convertible for arbitrary colors by adding a phosphor etc. to the lid of such optical permeability, and the resin of optical permeability. It is the same even when the conduction via or the electric circuit are provided into the inside of a substrate by the single layer or multilayered metallizing by co-firing which used tungsten, molybdenum, and copper, etc. as the main ingredients, or the thick film metallizing, or the thin film metallizing etc.

FIG. 75 illustrates the case where a conduction via is provided into the inside of a board-like substrate for light emitting device mounting.

The conduction via 40 which connects electrically the surface of this substrate on which the light emitting device is mounted with the opposite side of the surface is being formed in the inside of the substrate for light emitting device mounting 20 which is produced by using the sintered compact which comprises an aluminum nitride as the main ingredients.

The light emitting device 21, the light emitting device mounting surface of a substrate, and the surface electric circuit 41 which is provided on the opposite side by co-firing metallizing, thick film metallizing or thin film metallizing are connected electrically via the conduction via 40.

The electric power for driving a light emitting device 21 from this electric circuit 41 etc. is supplied from the substrate outside.

Even if the electric circuit is provided to the substrate for light emitting device mounting according to this invention shown in FIG. 75 by the single layer or multilayered metallizing by co-firing, thick film metallizing or thin film metallizing etc., since this substrate is the sintered compact which comprises an aluminum nitride as the main ingredients and luminescence from a light emitting device tends to become a scattered light, the light emitted from this light emitting device is emitted to the substrate exterior efficiently as a light 23 which penetrated the substrate 20, without receiving the loss from an electric circuit substantially.

As shown in FIG. 75, even if it is what formed a conduction via as a substrate, the luminescence 22 from this light emitting device has little loss to receive and is emitted to the substrate exterior, and the effect whose light emitted from this light emitting device is efficiently emitted to the substrate exterior as a light 23 which penetrated the substrate 20 is the same.

Even when not only the conduction via illustrated in FIG. 75 but also an electric circuit is provided into the inside of a substrate by the single layer or multilayered metallizing which comprises tungsten, molybdenum, or copper as the main ingredients, thick film metallizing which comprises gold, silver, copper, palladium, platinum, etc. as the main ingredients, or thin film metallizing, luminescence from this light emitting device has little loss to receive in the opposite side of the surface on which the light emitting device is mounted, the effect of being emitted to the substrate exterior efficiently as the light 23 which penetrated the substrate 20 is the same.

In the substrate for light emitting device mounting according to this invention, by connecting the electric circuit inside a substrate with a surface electric circuit by a conduction via 40 what has a more complicated electric circuit can be also manufactured.

It is the same even when the electric circuit by a conduction via, the single layer or multilayered metallizing by co-firing, thick film metallizing or thin film metallizing is provided into the inside of the substrate which has cavity space.

FIG. 76 illustrates a state when a conduction via is provided into the inside of the substrate for light emitting device mounting which has cavity space.

In FIG. 76, the conduction via 40 which connects electrically the surface of a substrate on which the light emitting device is mounted with the opposite side of the surface is formed in the inside of the substrate for light emitting device mounting 30 which has the cavity space 31 and is produced using the sintered compact which comprises an aluminum nitride as the main ingredients.

The light emitting device 21, the light emitting device mounting surface of a substrate, and the surface electric circuit 41 which is provided on the opposite side by co-firing metallizing, thick film metallizing or thin film metallizing are connected electrically via the conduction via 40.

As shown in FIG. 76, even if it is what formed a conduction via as a substrate, the luminescence 22 from this light emitting device has little loss to receive and is emitted to the substrate exterior, and the effect whose light emitted from this light emitting device is efficiently emitted to the substrate exterior as a light 23 which penetrated the substrate 30 is the same.

The light emitted from the light emitting device is also emitted to the substrate exterior from the side wall 33 of cavity space 31 as a light 24 which penetrated the substrate.

Even when not only the conduction via illustrated in FIG. 76 but also an electric circuit is provided into the inside of a substrate by the single layer or multilayered metallizing which comprises tungsten, molybdenum, or copper as the main ingredients, thick film metallizing which comprises gold, silver, copper, palladium, platinum, etc. as the main ingredients, or thin film metallizing, the luminescence from this light emitting device has little loss to receive in the opposite side of the surface on which the light emitting device is mounted, the effect of being emitted to the substrate exterior efficiently as the light 23 which penetrated the substrate 30 is the same.

Not only a substrate bottom which was illustrated to FIG. 76 but also the side wall portion of cavity space are contained as a portion in which the electric circuit is provided into the inside of the above-mentioned substrate by conduction via, single layer or multilayered metallizing which are formed by co-firing etc. using tungsten, molybdenum, or copper etc. as the main ingredients, thick film metallizing which is formed by printing by firing later on the sintered compact which comprises an aluminum nitride as the main ingredients and is obtained by once firing, and thin film metallizing by sputter, vapor deposition, or ion-plating etc.

In the substrate for light emitting device mounting according to this invention, what has a more complicated electric circuit can be manufactured by connecting the electric circuit inside a substrate with a surface electric circuit by a conduction via 40.

As a form in the case of actually using the substrate according to this invention for light emitting device mounting, it can be used in the form which mounts a light emitting device on one substrate directly as illustrated and explained in the above-mentioned FIG. 71-FIG. 76.

The electric connection with the substrate and light emitting device according to this invention is performed by the method by wire and the method by using non-wire connection material such as low melting point braze material and conductive adhesive, as shown in FIG. 71-FIG. 76, alone, respectively, or by combining these methods.

An electric circuit for driving a light emitting device by single layer or multilayered metallizing which are formed by co-firing etc. using tungsten, molybdenum, or copper etc. as the main ingredients, thick film metallizing which is formed by printing by firing later on the sintered compact which comprises an aluminum nitride as the main ingredients and is obtained by once firing, and thin film metallizing by sputter, vapor deposition, or ion-plating etc. can be provided on the external surface of a substrate, or in the inside of a substrate like a conduction via, as shown in FIG. 71-FIG. 76.

These electric circuits on the substrate surface and inside a substrate can be provided by using a conduction via etc. suitably, alone, or by combining simultaneously.

When the size of a light emitting device is comparatively as small as 1 mm order, or when it is difficult to mount directly on a substrate, in order to raise the mounting nature to the substrate of this light emitting device, once mounting this light emitting device in a submount, it can also mount on the substrate according to this invention.

FIGS. 77 and FIG. 78 show the section of the use form of the substrate according to this invention in the case of mounting a light emitting device using a submount.

As for FIG. 77, the example whose light emitting device 21 is once mounted on a submount 50 and whose submount 50 is mounted on the substrate 20 according to this invention is shown.

In FIG. 77, a light emitting device 21 and substrate for light emitting device mounting 20 are electrically connected by connecting the electric circuit 51 which is provided on the surface of a submount 50 by co-fired metallizing, thick film metallizing, or thin film metallizing, etc., and the surface electric circuit 26 which is provided on the light emitting device mounting surface side of a substrate 20 by co-fired metallizing which comprises as the main ingredients tungsten, molybdenum, or copper, etc., thick film metallizing which is formed by printing by firing later on the sintered compact which comprises an aluminum nitride as the main ingredients and is obtained by once firing, and thin film metallizing by sputter, vapor deposition, or ion-plating etc., by a wire 25.

In FIG. 77, the luminescence 22 from this light emitting device is emitted to the substrate exterior, without almost interrupting at the surface side on which the light emitting device of a substrate 20 is mounted.

In the opposite side of the surface on which the light emitting device is mounted, the light emitted from the light emitting device are also emitted to the substrate exterior as a light 23 which penetrated the substrate 20.

In this invention, what has an electric circuit by the single layer or multilayered metallizing which comprises tungsten, molybdenum, or copper as the main ingredients, and is formed in an inside by co-firing can also be used as a submount 50.

In FIG. 78, the example whose light emitting device 21 is once mounted on a submount 50 and whose submount 50 is mounted on the substrate for light emitting device mounting 30 according to this invention which has the cavity space 31 is shown.

In FIG. 78, a light emitting device 21 and substrate for light emitting device mounting 30 are electrically connected by connecting the electric circuit 51 which is provided on the surface of a submount 50 by co-fired metallizing which comprises as the main ingredients tungsten, molybdenum, or copper, etc., thick film metallizing which is formed by printing by firing later on the sintered compact which comprises an aluminum nitride as the main ingredients and is obtained by once firing, and thin film metallizing by sputter, vapor deposition, or ion-plating etc. and the surface electric circuit 26 which is provided on the light emitting device mounting surface side of a substrate 30 by thick film metallizing or thin film metallizing etc. by a wire 25.

In FIG. 78, at the surface side of a substrate 30 on which the light emitting device is mounted, the luminescence 22 from this light emitting device is emitted to the substrate exterior, without interrupting almost.

Also in the opposite side of the surface on which the light emitting device is mounted, the light emitted from the light emitting device is emitted to the substrate exterior as a light 23 which penetrated the substrate 30.

The light emitted from the light emitting device is emitted to the substrate exterior as a light 24 which penetrated the substrate also from the side wall of cavity space 31.

In this invention, as a submount 50, what has an electric circuit by the single layer or multilayered metallizing which comprises tungsten, molybdenum, or copper as the main ingredients, and is formed in an inside by co-firing can also be used.

As the form of a submount, not only what was illustrated in FIG. 77 and FIG. 78 but also what is various forms can use.

As for connection between this submount and the substrate according to this invention, not only what was illustrated in FIG. 77 and FIG. 78 but also various methods can use.

The section of the form of a submount and the connection state of this submount and the substrate according to this invention was illustrated in FIGS. 79 and FIG. 80.

FIG. 79 shows the example in which the electric circuit 52 by co-fired metallizing, thick film metallizing or thin film metallizing, etc. is given on the side of a submount 50.

In FIG. 79, a light emitting device 21 is once mounted on a submount 50, and this submount 50 is mounted on the substrate for light emitting device mounting 20 according to this invention.

In FIG. 79, a light emitting device 21 and substrate for light emitting device mounting 20 are electrically connected by connecting the electric circuit 51 which is provided on the surface of a submount 50 and the surface electric circuit 26 which is provided on the light emitting device mounting surface side of a substrate 20 by co-fired metallizing which comprises as the main ingredients tungsten, molybdenum, or copper, etc., thick film metallizing which is formed by printing by firing later on the sintered compact which comprises an aluminum nitride as the main ingredients and is obtained by once firing, and thin film metallizing by sputter, vapor deposition, or ion-plating etc., by the electric circuit 52 of the submount side.

In this invention, what has an electric circuit by the single layer or multilayered metallizing which comprises tungsten, molybdenum, or copper as the main ingredients, and is formed in an inside by co-firing can also be used as a submount 50, it can form a more complicated electric circuit by connecting with a surface electric circuit by a conduction via 53.

FIG. 80 shows the example in which the conduction via 63 is given in the inside of a submount 50.

In FIG. 80, a light emitting device 21 is once mounted on a submount 50, and this submount 50 is mounted on the substrate for light emitting device mounting 20 according to this invention.

In FIG. 80, a light emitting device 21 and substrate for light emitting device mounting 20 are electrically connected by connecting the conduction via 53 which is provided into the inside of a submount 50 and the surface electric circuit 26 which is provided on the light emitting device mounting surface side of a substrate 20 by co-fired metallizing which comprises as the main ingredients tungsten, molybdenum, or copper, etc., thick film metallizing which is formed by printing by firing later on the sintered compact which comprises an aluminum nitride as the main ingredients and is obtained by once firing, and thin film metallizing by sputter, vapor deposition, or ion-plating etc., by the conduction via 53 inside a submount.

In this invention, what has an electric circuit by the single layer or multilayered metallizing which comprises tungsten, molybdenum, or copper as the main ingredients, and is formed in an inside by co-firing can also be used as a submount 50, it can form a more complicated electric circuit by connecting with a surface electric circuit by a conduction via 53.

When it mounts the above-mentioned submount on the substrate for light emitting device mounting according to this invention, a substrate can use the thing of arbitrary forms.

Other than FIG. 77-FIG. 80, what has a conduction via, co-fired metallizing which comprises as the main ingredients tungsten, molybdenum, or copper, etc., thick film metallizing which is formed by printing by firing later on the sintered compact which comprises an aluminum nitride as the main ingredients and is obtained by once firing, and thin film metallizing by sputter, vapor deposition, or ion-plating etc., inside can be used as a substrate.

For example, what has forms, such as 1) what is the shape of a plate as shown with the mark 20 of FIG. 81 and has a conduction via 40 in the inside of a substrate, 2) what has the cavity space 31 as shown with the mark 30 of FIG. 82, and has a conduction via 40 in the inside of a substrate further, can be used.

FIGS. 81 and 82 are sectional views showing appearances that the light emitting device is being mounted on the substrate for light emitting device mounting according to this invention via the submount.

As a submount, the substrate for light emitting device mounting according to this invention which consists of a sintered compact which comprises an aluminum nitride as the main ingredients and which has optical permeability can be used.

Although the substrate for light emitting device mounting according to this invention consists of a sintered compact which comprises an aluminum nitride as the main ingredients and which has optical permeability, if the substrate for light emitting device mounting according to this invention is used as a submount, generation of heat from a light emitting device is missed effectively, a compact submount substrate can be designed using multilayered metallizing, thin film metallizing, etc., thermal stick accompanying the drive of a light emitting device is also borne, and it has optical permeability further, etc., it excels compared with the submount which consists of other materials.

Among the substrate for light emitting device mounting according to this invention, a sectional view of what has the cavity space in the state where the light emitting device is not mounted is illustrated in FIG. 83 and FIG. 84.

In FIG. 83, the substrate for light emitting device mounting 30 which has cavity space is being constituted by the plate-like base 34, frame 35, and lid 32.

Cavity space 31 is formed by joining a frame 35 to the plate-like base 34 in the junction part 36.

In this invention, in the above-mentioned substrate for light emitting device mounting 30, it is either that either consists of a sintered compact which comprises an aluminum nitride as the main ingredients among a base 34 or a frame 35, or that both consists of a sintered compact which comprises an aluminum nitride as the main ingredients among a base 34 or a frame 35.

What comprises as the main ingredients various metals, alloys, glasses, ceramics, resins etc. if needed in addition to the sintered compact which comprises an aluminum nitride as the main ingredients as a material of a base 34 or a frame 35 can be used.

Since luminescence from a light emitting device can be emitted without a much loss to the substrate exterior if transparent glass, resin, ceramics, etc. are used as a material of a base 34 or a frame 35, it is desirable.

If what comprises as the main ingredients various metals, alloys, glasses, ceramics, resins etc. which are optical impermeableness and cannot penetrate light easily is used as a material of a base 34 or a frame 35, since luminescence from a light emitting device stops being able to penetrate a substrate easily in that portion, it will function effectively if it is used in order to control a direction which does not want to emit this luminescence into the substrate exterior.

In the above-mentioned substrate for light emitting device mounting 30, the lid 32 for sealing cavity space is attached.

The lid 32 is usually attached to a frame after mounting a light emitting device, the lid 32 seals a light emitting device by a sealing material which comprises as the main ingredients solder, braze material, glass, and resin, etc. in the seal part 37 in that case.

The material which comprises as the main ingredients various metal, an alloy, glass, ceramics, resin, etc. can be used as a material of a lid 32.

If the sintered compact which comprises an aluminum nitride as the main ingredients and which has optical permeability, transparent glass, resin, ceramics, etc. are used as a material of a lid 32, since luminescence from a light emitting device can be emitted to the substrate exterior from a lid, without a much loss, it is desirable.

If what comprises as the main ingredients various metals, alloys, glasses, ceramics (the sintered compact which comprises an aluminum nitride as the main ingredients and is optical impermeableness which cannot penetrate light easily is included), resins etc. which are optical impermeableness and cannot penetrate light easily is used as a material of a lid 32, since luminescence from a light emitting device stops being able to penetrate a lid easily, it is effective if this luminescence does not require the emitting to the direction in which a lid is attached.

Hermetic seal will be attained, if metal, an alloy, glass, ceramics, etc. are used as a material of a lid and solder, braze material, glass, etc. are used as a sealing agent on the occasion of seal.

In addition, it is not necessary to use a lid 32 if needed.

In that case, seal of a light emitting device can be performed by filling up cavity space 31 with transparent resin etc.

In FIG. 83, a conduction via 40 and the surface electric circuit 41 which is being formed on the external surface of a substrate are formed in the base 34, and the surface electric circuit 26 is formed also on the substrate surface of light emitting device mounting side.

The single layer or the multilayered electric circuit which are formed by co-firing etc. using tungsten, molybdenum, or copper as the main ingredients can also provide in the inside of a substrate if needed, besides the above-mentioned conduction via, an external electric circuit, and the electric circuit formed on the substrate surface of light emitting device mounting side.

The above-mentioned conduction via, an external electric circuit, and the electric circuit formed on the substrate surface of light emitting device mounting side can be provided also in a frame 35 if needed.

It is not necessary to provide suitably the above-mentioned conduction via, an external electric circuit, and the electric circuit formed on the substrate surface of light emitting device mounting side if needed.

As for the above-mentioned conduction via and various electric circuits, it is preferred to form by metallizing by co-firing, thick film metallizing which is formed by printing by firing later on the sintered compact of optical permeability which comprises an aluminum nitride as the main ingredients and is obtained by once firing, and thin film metallizing by sputter, vapor deposition, or ion-plating etc.

There is especially no influence in the performance as a substrate for light emitting device mounting according to this invention just because it does not provide the above-mentioned conduction via, the electric circuit formed on the external surface, the electric circuit formed on the substrate surface of light emitting device mounting side, or the electric circuit inside a substrate.

FIG. 83 is drawn as a substrate for light emitting device mounting is constituted by a method of joining the base 34 and the frame 35, which are a respectively another material.

On the other hand, by the sintered compact which comprises an aluminum nitride as the main ingredients as a substrate for light emitting device mounting 30 according to this invention, that whose base 34 and the frame 35 were united in the state where there is no junction part 36 which was shown in FIG. 83 is illustrated in FIG. 84.

By such a sintered compact which comprises an aluminum nitride as the main ingredients, that whose base 34 and the frame 35 were united in the state where there is no junction part 36 which was shown in FIG. 83 was illustrated even in FIG. 74, FIG. 76, FIG. 78, and FIG. 82.

Even if it is the substrate for light emitting device mounting in which cavity space 31 is formed by being unified by the sintered compact which comprises an aluminum nitride as the main ingredients, there is no change in the ability to seal a light emitting device by the charge of a sealing material which comprises solder, braze material, glass, resin, etc. as the main ingredients in the seal part 37 using a lid 32.

A lid 32 is usually attached in a frame after mounting a light emitting device, and a lid 32 seals a light emitting device by a sealing material which comprises solder, braze material, glass, resin, etc. as the main ingredients in the seal part 37 in that case.

The material which comprises as the main ingredients various metal, an alloy, glass, ceramics, resin, etc. can be used as a material of a lid 32.

If the sintered compact which comprises an aluminum nitride as the main ingredients and which has optical permeability and the transparent glass, resin, ceramics, etc. are used as a material of a lid 32, since luminescence from a light emitting device can be emitted to the substrate exterior from a lid, without a much loss, it is desirable.

If what comprises as the main ingredients various metals, alloys, glasses, ceramics (the sintered compact which comprises an aluminum nitride as the main ingredients and is optical impermeableness which cannot penetrate light easily is included), resins etc. which are optical impermeableness and cannot penetrate light easily is used as a material of a lid 32, since luminescence from a light emitting device stops being able to penetrate a lid easily, it is effective if this luminescence does not require the emitting to the direction in which a lid is attached.

Hermetic seal will be attained, if metal, an alloy, glass, ceramics, etc. are used as a material of a lid and solder, braze material, glass, etc. are used as a sealing agent on the occasion of seal.

In addition, it is not necessary to use a lid 32 if needed.

In that case, seal of a light emitting device can be performed by filling up cavity space 31 with transparent resin etc.

In FIG. 84, a conduction via 40 and the surface electric circuit 41 which is being formed on the external surface of a substrate is formed in the portion 38 of substrate for light emitting device mounting 30 in which the light emitting device is mounted, and the surface electric circuit 26 is formed also on the substrate surface of light emitting device mounting side.

The single layer or the multilayered electric circuit which are formed by co-firing etc. using tungsten, molybdenum, or copper as the main ingredients can also provide in the inside of a substrate if needed besides the above-mentioned conduction via, an external electric circuit, and the electric circuit formed on the substrate surface of light emitting device mounting side.

The above-mentioned conduction via, an external electric circuit, the electric circuit formed on the substrate surface of light emitting device mounting side, and the internal electric circuit formed in the inside of a substrate can be provided also in the side wall portion 33 which forms cavity space if needed.

It is not necessary to provide suitably the above-mentioned conduction via, an external electric circuit, the electric circuit formed on the substrate surface of light emitting device mounting side, and the internal electric circuit formed in the inside of a substrate if needed.

As for the above-mentioned conduction via and various electric circuits, it is preferred to form by metallizing by co-firing, thick film metallizing which prints and forms later on the sintered compact which comprises an aluminum nitride as the main ingredients and is obtained by once firing, and thin film metallizing by sputter, vapor deposition, or ion-plating etc.

There is especially no influence in the performance as a substrate for light emitting device mounting according to this invention just because it does not provide the above-mentioned conduction via, an external electric circuit, the electric circuit formed on the substrate surface of light emitting device mounting side, or the electric circuit inside a substrate.

In this invention, what formed cavity space by junction to a base and a frame as illustrated in FIG. 83 as a substrate for light emitting device mounting which has cavity space can be used.

In the case of the substrate for light emitting device mounting which has the cavity space by this constitution, it is either that either is a sintered compact which comprises alumininum nitride as the main ingredients among a base or a frame, or both are a sintered compact which comprises a lumininum nitride as the main ingredients among a base or a frame.

What comprises as the main ingredients various metals, alloys, glasses, ceramics, resins etc. if needed in addition to the sintered compact which comprises an aluminum nitride as the main ingredients as a material of a base or a frame can be used.

Since luminescence from a light emitting device can be emitted without a much loss to the substrate exterior if transparent glass, resin, ceramics, etc. are used as a material of a base or a frame, it is desirable.

If what comprises as the main ingredients various metals, alloys, glasses, ceramics, resins etc. which are optical impermeableness and cannot penetrate light easily is used as a material of a base or a frame, since luminescence from a light emitting device stops being able to penetrate a substrate easily in the portion, it will function effectively if it is used in order to control a direction which does not want to emit this luminescence into the substrate exterior.

In the above-mentioned substrate for light emitting device mounting according to this invention which is obtained by junction to the base and frame, a lid can be attached for the purpose for sealing cavity space etc.

A lid is usually attached to a frame after mounting a light emitting device, and a lid seals a light emitting device by a sealing material which comprises solder, braze material, glass, resin, etc. as the main ingredients in a seal part in that case.

The material which comprises as the main ingredients various metal, an alloy, glass, ceramics, resin, etc. can be used as a material of a lid.

If the sintered compact which comprises an aluminum nitride as the main ingredients and which has optical permeability and the transparent glass, resin, ceramics, etc. are used as a material of a lid, since luminescence from a light emitting device can be emitted to the substrate exterior from a lid, without much loss, it is desirable.

If what comprises as the main ingredients various metals, alloys, glasses, ceramics (the sintered compact which comprises an aluminum nitride as the main ingredients and is optical impermeableness which cannot penetrate light easily is included), resins etc. which are optical impermeableness and cannot penetrate light easily is used as a material of a lid, since luminescence from a light emitting device stops being able to penetrate a lid easily, it is effective if this luminescence does not require the emitting to the direction in which a lid is attached.

Hermetic seal will be attained, if metal, an alloy, glass, ceramics, etc. are used as a material of a lid and solder, braze material, glass, etc. are used as a sealing agent on the occasion of seal.

In addition, it is not necessary to use a lid if needed.

In that case, seal of a light emitting device can be performed by filling up cavity space with transparent resin etc.

In the above-mentioned substrate for light emitting device mounting according to this invention which is obtained by junction to the base and frame, a single layer or the multilayered electric circuit can also be provided into the inside of a substrate if needed besides a conduction via, the electric circuit formed on the substrate external surface, and the electric circuit formed on the substrate surface of light emitting device mounting side.

The above-mentioned conduction via, an external electric circuit, and the electric circuit formed on the substrate surface of light emitting device mounting side can be provided also in a frame if needed.

It is not necessary to provide suitably the above-mentioned conduction via, an external electric circuit, the electric circuit formed on the substrate surface of light emitting device mounting side, and the internal electric circuit formed in the inside of a substrate if needed.

As for the above-mentioned conduction via and various electric circuits, it is preferred to form by metallizing by co-firing, thick film metallizing which prints and forms later on the sintered compact of optical permeability which comprises an aluminum nitride as the main ingredients and is obtained by once firing, and thin film metallizing by sputter, vapor deposition, or ion-plating etc.

There is especially no influence in the performance as a substrate for light emitting device mounting according to this invention just because it does not provide the above-mentioned conduction via, an external electric circuit, the electric circuit formed on the substrate surface of light emitting device mounting side, or the electric circuit inside a substrate.

In the substrate for light emitting device mounting which has the cavity space and is illustrated in FIG. 83, when performing junction between the above-mentioned base 34 and a frame 35, various methods can be used suitably.

For example, there are the method, such as the method which uses adhesives, such as glass and resin, the junction method by using solder, braze material, etc. after metallizing or plating which is given to either of a base or a frame at least, the junction method by heat sticking by pressure, the junction method by using an ultrasonic wave, and the junction method by friction, etc.

When using adhesives, it is preferred to use a material of high optical permeability.

When all of a base and a frame are the sintered compacts which comprise an aluminum nitride as the main ingredients, also there is a method to join by the co-firing after adhesion of these powder compacts which comprise an aluminum nitride as the main ingredients using the homogeneous powder paste which comprises an aluminum nitride as the main ingredients, etc.

When only either is the sintered compact which comprises an aluminum nitride as the main ingredients and which has optical permeability among a base and a frame, the coefficients of thermal expansion between a base and a frame usually differ in many cases.

Thus, when the coefficients of thermal expansion between a base and a frame differ, junction by using soft adhesives, such as silicone resin, is preferred.

Since optical permeability is also high, adhesives, such as this silicone resin, are preferred.

Even if the thermal expansion coefficient between a base and a frame is equal or is a near case, the above soft adhesives, such as silicone resin, can be used.

In this invention, what formed cavity space after having been unified by the sintered compact which comprises an aluminum nitride as the main ingredients as illustrated in FIG. 84 as a substrate for light emitting device mounting which has cavity space can be used.

In the above-mentioned substrate for light emitting device mounting according to this invention which is formed after having been unified by the sintered compact which comprises an aluminum nitride as the main ingredients, a lid can be attached for the purpose for sealing cavity space etc.

A lid is usually attached to a frame after mounting a light emitting device, and a lid seals a light emitting device by a sealing material which comprises solder, braze material, glass, resin, etc. as the main ingredients in a seal part in that case.

The material which comprises as the main ingredients various metal, an alloy, glass, ceramics, resin, etc. can be used as a material of a lid.

If the sintered compact which comprises an aluminum nitride as the main ingredients and which has optical permeability and the transparent glass, resin, ceramics, etc. are used as a material of a lid, since luminescence from a light emitting device can be emitted to the substrate exterior from a lid, without a much loss, it is desirable.

If what comprises as the main ingredients various metals, alloys, glasses, ceramics (the sintered compact which comprises an aluminum nitride as the main ingredients and is optical impermeableness which cannot penetrate light easily is included), resins etc. which are optical impermeableness and cannot penetrate light easily is used as a material of a lid, since luminescence from a light emitting device stops being able to penetrate a lid easily, it is effective if this luminescence does not require the emitting to the direction in which a lid is attached.

Hermetic seal will be attained, if metal, an alloy, glass, ceramics, etc. are used as a material of a lid and solder, braze material, glass, etc. are used as a sealing agent on the occasion of seal.

In addition, it is not necessary to use a lid if needed.

In that case, seal of a light emitting device can be performed by filling up cavity space with transparent resin etc.

In the above-mentioned substrate for light emitting device mounting according to this invention which is formed after having been unified by the sintered compact which comprises an aluminum nitride as the main ingredients, a single layer or the multilayered electric circuit can also be provided into the inside of a substrate if needed besides a conduction via, and the electric circuit formed on the substrate surface.

The above-mentioned conduction via and an electric circuit can be provided also in the side wall part which forms cavity space if needed.

It is not necessary to provide suitably the above-mentioned conduction via, the electric circuit formed on the substrate surface, and the internal electric circuit formed in the inside of a substrate if needed.

As for the above-mentioned conduction via and various electric circuits, it is preferred to form by metallizing by co-firing, thick film metallizing which prints and forms later on the sintered compact of optical permeability which comprises an aluminum nitride as the main ingredients and is obtained by once firing, and thin film metallizing by sputter, vapor deposition, or ion-plating etc.

There is especially no influence in the performance as a substrate for light emitting device mounting according to this invention just because it does not provide the above-mentioned conduction via, the electric circuit formed on the substrate surface of the opposite side of light emitting device mounting side, the electric circuit formed on the substrate surface of light emitting device mounting side, or the electric circuit inside a substrate.

FIG. 100 shows the example by which the electric circuit is formed in the inside of the substrate for light emitting device mounting of the shape of a board which consists of a sintered compact which comprises an aluminum nitride as the main ingredients.

The internal electric circuit 43 is formed in the substrate for light emitting device mounting 20 which consists of a sintered compact which comprises an aluminum nitride as the main ingredients in FIG. 100.

The surface electric circuit 27 is formed on substrate for light emitting device mounting 20, and it is being fixed by connection material (not shown in a figure), such as low melting point braze material and conductive adhesive.

An electric circuit 27 is formed on the sintered compact which comprises an aluminum nitride as the main ingredients by metallizing by co-firing, thick film metallizing, or thin film metallizing etc. usually.

A light emitting device 21 is mounted in the portion in which the electric circuit 27 was formed in substrate for light emitting device mounting 20, and it is being connected electrically with the electric circuit 26 of a substrate surface of light emitting device mounting side by the wire 25.

The surface electric circuit 26 is connected with the internal electric circuit 43 by a conduction via 40, and is connected further with the surface electric circuit 41 which is being formed on the external surface of a substrate by the conduction via 40.

In this invention, even if the electric circuit as shown in FIG. 100 is formed in the inside of the substrate for light emitting device mounting which consists of a sintered compact which comprises an aluminum nitride as the main ingredients or on the surface of this substrate, it is rare that the intensity of the light emitted from the light emitting device which penetrates a substrate and is emitted to the exterior is reduced by the electric circuit.

FIG. 101 shows another example by which the electric circuit is formed in the inside of the substrate for light emitting device mounting of the shape of a board which consists of a sintered compact which comprises an aluminum nitride as the main ingredients.

The internal electric circuit 43 is formed in the substrate for light emitting device mounting 30 which has the cavity space which consists of a sintered compact which comprises an aluminum nitride as the main ingredients in FIG. 101.

A light emitting device 21 is mounted on substrate for light emitting device mounting 30, and it is being connected electrically with the electric circuit 26 of a substrate surface of light emitting device mounting side by the non-wire-like connection material 29 (the connection material connected to another light emitting device electrode is not illustrated).

The surface electric circuit 26 is connected to the internal electric circuit 43 by the conduction via 40, and this internal electric circuit 43 is further connected with the surface electric circuit 41 which is being formed on the substrate external surface of the opposite side of the substrate surface on which the light emitting device is mounted and the electric circuit 42 which is being formed on the substrate external surface (side of a substrate) which is in the opposite side of the side wall 33 in the cavity space of a substrate by the conduction via 40.

In this invention, even if the electric circuit as shown in FIG. 101 is formed in the inside of the substrate for light emitting device mounting which consists of a sintered compact which comprises an aluminum nitride as the main ingredients or on the surface of this substrate, it is rare that the intensity of the light emitted from the light emitting device which penetrates a substrate and is emitted to the exterior is reduced by the electric circuit.

FIG. 85 is a sectional view showing the example of a conventional substrate.

The light emitting device 21 is mounted in the portion for containing 103 of a substrate 100 which has the reflective part 101 in FIG. 85.

The luminescence 102 from a light emitting device is reflected by the reflective part 101, and it is emitted to the substrate exterior from the substrate surface side on which the light emitting device is mounted.

The material which constitutes a substrate 100 is what has high reflective ability to luminescence from a light emitting device and reflects most of this luminescence to the direction of the substrate mounting surface side, or what is easy to scatter about and to absorb the luminescence from this light emitting device, or what has impermeableness to luminescence from this light emitting device as the substrate material itself, etc., for example, like what comprises aluminum, white ceramics, or resin as the main ingredients, it is difficult eventually to make luminescence from this light emitting device penetrate to the opposite side of the surface on which the light emitting device is mounted.

As mentioned above, in conventional substrate for light emitting device mounting, that the emitting (arrow described by the dotted line of a mark 104) of the luminescence from a light emitting device to the substrate exterior from the surface of the opposite side of the surface of the side which mounts a light emitting device is difficult (it is being realized by the substrate for light emitting device mounting according to this invention).

Usually, although the sintered compact which comprises an aluminum nitride as the main ingredients tends to become what has small optical permeability according to factors, such as composition and sintered density, according to this invention, the sintered compact which comprises an aluminum nitride as the main ingredients and which has optical permeability can be obtained comparatively easily by using the conventional method as below.

That is, it is manufactured by heating the powder compact which comprises an aluminum nitride as the main ingredients usually in the temperature range of about 1500-2400 degrees C. under ordinary pressure or under decompression or under pressurization, of the non-oxidizing atmosphere, such as the neutral atmosphere which comprises as the main ingredients at least one or more materials, such as helium, neon, argon, and nitrogen, or the reduced atmosphere containing at least one or more materials, such as hydrogen, carbon monoxide, carbon, and hydrocarbon.

The range of about 10 minutes-3 hours is usually used as firing time.

It may be manufactured by firing in a vacuum.

It is also manufactured by the hot pressing method or the HIP (hot isostatic pressing) firing method.

As firing conditions by the hot pressing method, the firing temperature range of about 1500-2400 degrees C. and the firing time of the range of about 10 minutes-3 hours and the pressure range of about 10 Kg/cm²-1000 Kg/cm² are usually used in the above-mentioned non-oxidizing atmosphere or a vacuum.

As firing conditions by the HIP method, the above-mentioned non-oxidizing atmosphere is pressurized at the range of about 500 Kg/cm²-10000 Kg/cm², and the firing temperature range of about 1500-2400 degrees C. and the firing time of the range of about 10 minutes-10 hours are usually used.

It is easy to obtain the sintered compact which comprises an aluminum nitride as the main ingredients and is more excellent in optical permeability if the device that an aluminum nitride ingredient exists in firing atmosphere on the occasion of the above-mentioned firing is performed.

That is, it becomes easier to obtain the sintered compact which comprises an aluminum nitride as the main ingredients and is excellent in optical permeability if the vapor which comprises an aluminum nitride as the main ingredients exists in firing atmosphere.

As a method of making an aluminum nitride ingredient exist in firing atmosphere, for example, there is the method of supplying into atmosphere by evaporation from this fired thing itself during firing the powder compact which comprises an aluminum nitride as the main ingredients or the sintered compact which comprises an aluminum nitride as the main ingredients, which are the fired thing, or supplying from other than this fired thing.

Concretely, for example, as a method of specifically supplying an aluminum nitride ingredient into firing atmosphere from the fired thing itself, there are effects, that is, this fired thing is contained and fired in the firing container, such as the “saggar” and the “saggar”, or in the firing implement, such as the “setter”, which are produced with material which does not contain carbon as much as possible, such as boron nitride or tungsten, and molybdenum, or what carried out coating of the surface by boron nitride is used even if the firing container or firing implement containing carbon are used, etc.

The sintered compact which comprises an aluminum nitride as the main ingredients and is excellent in optical permeability is also producible by firing a fired thing, where the degree of sealing is raised further after containing in a firing container or an firing implement etc.

As a method of specifically supplying an aluminum nitride ingredient into firing atmosphere from other than the fired thing, the sintered compact which comprises an aluminum nitride as the main ingredients and is excellent in optical permeability is producible by containing and firing the fired thing in the firing container, such as the “saggar” and the “saggar”, or in the firing implement, such as the “setter”, which are produced with material which comprises an aluminum nitride as the main ingredients.

The sintered compact which comprises an aluminum nitride as the main ingredients and is excellent in optical permeability tends to be acquired by the method of embedding a fired thing into the powder which comprises an aluminum nitride as the main ingredients, and firing it.

Even if they are fired in the above-mentioned firing container or firing implement with at least one or more things which are other than a fired thing and which are, selected from the powder comprising an aluminum nitride as the main ingredients, the powder compact comprising an aluminum nitride as the main ingredients, or the sintered compact comprising an aluminum nitride as the main ingredients, the sintered compact which comprises an aluminum nitride as the main ingredients and is excellent in optical transmissivity is also producible.

It is suitable when firing extensive processing of a product and the thing of complicated form, since a fired thing can be fired in the free state by this method.

In addition, using the firing container or firing implement which are produced with the material which comprises an aluminum nitride as the main ingredients among the above-mentioned firing container or firing implement, even if they are fired with at least one or more things which are other than a fired thing and which are selected from the powder comprising an aluminum nitride as the main ingredients, the powder compact comprising an aluminum nitride as the main ingredients, or the sintered compact comprising an aluminum nitride as the main ingredients, the sintered compact which comprises an aluminum nitride as the main ingredients and is excellent in optical transmissivity is also producible.

In the method of producing the sintered compact which comprises an aluminum nitride as the main ingredients and is excellent in optical permeability by making the above-mentioned aluminum nitride ingredient exist in firing atmosphere, usually, supplying from other than a fired thing can produce the sintered compact which comprises an aluminum nitride as the main ingredients and is more excellent in optical permeability than supplying this aluminum nitride ingredient into atmosphere by evaporation from the fired thing itself.

In addition, in the method of producing a sintered compact which comprises an aluminum nitride as the main ingredients and is excellent in optical permeability by making an aluminum nitride ingredient exist in firing atmosphere, usually, since it does not vaporize the ingredients while firing, such as additives like sintering aids and such as oxygen or unescapable impurities which are contained in a raw material, the sintered compact which comprises an aluminum nitride as the main ingredients and has the almost same composition as a powder compact is producible.

In addition, when firing by the hot-press method or the HIP method is performed, if this sintered compact which comprises an aluminum nitride as the main ingredients is re-fired under pressurization after this powder compact is pre-fired and was made into the sintered compact which comprises an aluminum nitride as the main ingredients, it is easy to obtain the sintered compact which comprises an aluminum nitride as the main ingredients and is more excellent in optical permeability, than firing under pressurization the powder compact which comprises an aluminum nitride as the main ingredients as it is.

Also in firing by the hot-press method or the HIP method, when making an aluminum nitride ingredient exist in firing atmosphere by various methods, such as using the above-mentioned firing container and firing implement, it is desirable to produce the sintered compact which comprises an aluminum nitride as the main ingredients and is more excellent in optical permeability.

When raising the optical permeability of the sintered compact which comprises an aluminum nitride as the main ingredients, conditions other than the above can also be chosen if needed.

For example, if comparatively long time firing of not less than 3 hours is performed at the temperature not less than 1750 degrees C. in reduced atmosphere if required, since the contained oxygen or ingredients which are used as sintering aids such as a rare-earth compound and an alkaline earth metal compound or ingredients which are used as a firing temperature reduction-ized agents such as an alkali metal and silicon or metal ingredients which are used as black-ized agents such as Mo, W, V, Nb, Ta, Ti or carbon or unescapable metal ingredients other than Mo, W, V, Nb, Ta, Ti, etc. are able to be vaporized, removed, and decreased, the content of the metal ingredients, silicon, or compound containing carbon other than ALON (Aluminum oxynitride: the compound between AlN and Al₂O₃: compound which is produced by the chemical reaction between AlN and Al₂O₃ and have a spinel type crystal structure) or the above-mentioned aluminum is decreased and AlN purity increases, as the result, it is easy to manufacture the sintered compact which comprises an aluminum nitride as the main ingredients and whose optical permeability improved.

As mentioned above, although the optical permeability of the sintered compact which comprises an aluminum nitride as the main ingredients can be raised more by performing long time firing of not less than 3 hours at the temperature not less than 1750 degrees C. in reduced atmosphere if required, the aluminum nitride particle tends to grow in the sintered compact which comprises an aluminum nitride as the main ingredients by this firing and this inventor is surmising that the decrease of particle boundaries is also one of the factors in which optical permeability becomes easy to increase, as the result.

As the firing temperature when manufacturing the sintered compact which comprises an aluminum nitride as the main ingredients and whose optical permeability improved by raising the AlN purity of the sintered compact which comprises an aluminum nitride as the main ingredients or by growing an aluminum nitride particle as mentioned above, not less than 1900 degrees C. are more preferred in order to shorten firing time, not less than 2050 degrees C. are still more preferred, and not less than 2100 degrees C. are the most preferred.

Of course, it is not less than 2050 degrees C, even if it is a high temperature not less than 2100 degrees C., it can fire without sublimating most AlN ingredient itself.

In order to manufacture the sintered compact which comprises an aluminum nitride as the main ingredients and whose optical permeability improved by raising the AlN purity of the sintered compact which comprises an aluminum nitride as the main ingredients or by growing of an aluminum nitride particle, it is usually preferred to make the firing time not less than 10 hours in the range of a firing temperature of 1750 degrees C.-1900 degrees C., a bigger effect is furthermore acquired with 24 or more hours.

In the firing temperature not less than 1900 degrees C., the effect which raises optical permeability enough is acquired with the firing time not less than 6 hours, a bigger effect for raising optical permeability is furthermore acquired with not less than 10 hours.

In the firing temperature not less than 2050 degrees C., the effect for raising optical permeability enough is acquired with firing time not less than 4 hours, a bigger effect for raising optical permeability is furthermore acquired with not less than 6 hours.

In the firing temperature not less than 2100 degrees C., the effect for raising optical permeability enough is acquired with firing time not less than 3 hours, a bigger effect for raising optical permeability is furthermore acquired with not less than 4 hours.

As mentioned above, when the optical permeability of this sintered compact is raised by raising the AlN purity of a sintered compact which comprises an aluminum nitride as the main ingredients or by making an aluminum nitride particle grow up, there is such a relation, if a firing temperature is raised a firing time can be shortened and if a firing temperature is made low a firing time becomes long, and a firing temperature and firing time can use arbitrary conditions.

As mentioned above, As for the firing atmosphere when manufacturing the sintered compact which comprises an aluminum nitride as the main ingredients and has higher optical permeability, it is preferred to use the reduced atmosphere which contains at least one or more materials, such as hydrogen, carbon monoxide, carbon, and hydrocarbon, in order to make vaporization of impurities easier.

Although it may also be what comprises as the main substance at least one or more of hydrogen, carbon monoxide, carbon, and hydrocarbon, etc. as reduced atmosphere, it may be the atmosphere which contains at least one or more of hydrogen, carbon monoxide, carbon, and hydrocarbon, etc. minute amount of about 0.1 ppm in the ambient atmosphere which comprises as the main ingredients at least one or more of nitrogen, helium, neon, and argon, etc.

When the reduced atmosphere is an atmosphere which contains very small amount of at least one or more of hydrogen, carbon monoxide, carbon, and hydrocarbon, etc. in the ambient atmosphere which comprises at least one or more of nitrogen, helium, neon, and argon, etc. as the main substance, what contains at least one or more of hydrogen, carbon monoxide, carbon, and hydrocarbon, etc. not less than 10 ppm is more preferred, in order to make the sintered compact which comprises an aluminum nitride as the main ingredients high purity.

In the above-mentioned reduced atmosphere, what contains at least one or more of hydrogen, carbon monoxide, carbon, and hydrocarbon, etc. not less than 100 ppm is still more desirable, in order to make the sintered compact which comprises an aluminum nitride as the main ingredients high purity and to raise optical permeability.

There is especially no need to use reduced atmosphere as the ambient atmosphere when manufacturing the sintered compact which comprises an aluminum nitride as the main ingredients and raised optical permeability, and it is enough if it is a non-oxidizing atmosphere.

When manufacturing the sintered compact which comprises an aluminum nitride as the main ingredients and raised optical permeability by raising the purity of AlN or growing up an aluminum nitride particle by performing the comparatively long time firing as mentioned above, it may be fired by using the powder compact which comprises an aluminum nitride raw material powder as the main ingredients, and what was made into the sintered compact by pre-firing the above-mentioned powder compact may be used.

It is also preferred to use the powder compact and a sintered compact which comprise an aluminum nitride as the main ingredients containing at least one or more materials selected from a rare-earth compound or an alkaline earth metal compound other than aluminum nitride which is a main ingredient.

When manufacturing the sintered compact which comprises an aluminum nitride as the main ingredients and has a high AlN purity, the powder compact and sintered compact which used raw material powder as it is are used especially without sintering aids, preferably, although the ingredient contained may be vaporized and removed by heating for not less than 3 hours at the temperature not less than 1750 degrees C. among the above reduced atmospheres, if using the powder compact and sintered compact which comprise an aluminum nitride as the main ingredients and contain at least one or more materials selected from a rare-earth compound or an alkaline earth metal compound as mentioned above, ingredients other than AlN are vaporized, removed, and reduced, so high purification is easy to be attained, it is more desirable.

And, by using the powder compact which comprises an aluminum nitride as the main ingredients and contained simultaneously at least one or more compounds selected from a rare earth element compound and at least one or more compounds selected from an alkaline-earth-metals compound, or by using what once fired the powder compact and was made into the sintered compact, it becomes possible to lower a firing temperature by about 50 degrees C.-300 degrees C. if it is compared with the case where a rare-earth compound or an alkaline earth metal compound is used alone, respectively, ingredients other than AlN is effectively vaporized, removed, and reduced, so high purification is easy to be attained, it is more desirable.

The aluminum nitride sintered compact which consists of an AlN single phase substantially by the analysis using methods, such as X-ray diffraction, by such method can also be manufactured.

In this invention, it is effective to raise the AlN purity of the sintered compact which comprises an aluminum nitride as the main ingredients and is used as a substrate in order to raise the optical permeability of the substrate for light emitting device mounting which used this sintered compact.

On the other hand, it is also effective to use the sintered compact which comprises an aluminum nitride as the main ingredients and whose aluminum nitride particle grew up as a substrate for light emitting device mounting.

That is, for example, as for the sintered compact which comprises an aluminum nitride as the main ingredients and is obtained by firing the above-mentioned powder compact and sintered compact for comparatively long hours of not less than 3 hours at the temperature not less than 1750 degrees C., while the aluminum nitride particle is growing greatly, comparatively many ingredients, such as sintering aid, such as a rare-earth compound and an alkaline earth metal compound, or oxygen, or ingredients used as a firing temperature reduction-ized agent, such as an alkali metal and silicon, or the metal ingredients, such as Mo, W, V, Nb, Ta, and Ti and carbon which are used as a black-ized agent, or unescapable metal ingredients other than Mo, W, V, Nb, Ta, and Ti, or ALON and metal ingredients other than the above-mentioned aluminum, and silicon, or the compound containing carbon, etc., may remain.

While comparatively many ingredients other than such an aluminum nitride are included, even if it is the sintered compact whose aluminum nitride particle has grown, optical permeability tends to increase, and it becomes effective to use this sintered compact as a substrate for light emitting device mounting.

That is, in this invention, even if the AlN purity of the sintered compact which comprises an aluminum nitride as the main ingredients and is used as a substrate for mounting a light emitting device is not necessarily high, it is shown that it is effective to enlarge the aluminum nitride particle in a sintered compact.

As that reason, if the size of the aluminum nitride crystal grain increase in a sintered compact since a grain boundary will decrease the influence of a grain boundary decreases and this AlN particle which increased greatly becomes easy to generate the character near a single crystal, it is surmised that it will be because optical permeability will become easy to be raised as a result.

In using this sintered compact as a substrate for light emitting device mounting, the purity in an aluminum nitride sintered compact affects the junction nature of this metallizing to the substrate at the time of forming the electric circuit by thick film metallizing or thin film metallizing, or the junction nature between sealing agents, such as or glass, and resin, and a substrate, or junction nature with a different-species material according to adhesives, braze material, etc. in addition to this, in many cases.

That is, in the substrate for light emitting device mounting which consists of a sintered compact which comprises an aluminum nitride as the main ingredients and whose aluminum nitride particle grew up, even if especially AlN purity is not high, it should just be the AlN purity corresponding to the material or its formation method of this metallizing, the quality or its formation method of a sealing material, and the quality or its formation method of adhesives, or braze material.

As mentioned above, if it fires at a high temperature for a long time, the size of the aluminum nitride crystal grain in a sintered compact will increase, but usually it is easy to produce simultaneously vaporization of the sintering aids and additive, etc. in the sintered compact which comprises an aluminum nitride as the main ingredients.

In order to control vaporization of the sintering aids and additive, etc. in an AlN sintered compact only by making the size of the aluminum nitride crystal grain in the sintered compact which comprises an aluminum nitride as the main ingredients increase, it is preferred to use non-oxidizing atmosphere, such as nitrogen and argon, etc., which has comparatively little of reduction nature ingredients, such as hydrogen, carbon monoxide, carbon, and hydrocarbon, as firing atmosphere.

As a firing furnace, what is the method using carbon heating element, the method which makes carbon generate heat by electromagnetic induction, or what has the furnace material made from carbon, etc., is usable, for example, other than these, it is effective to use what is the method which uses high melting point metals, such as tungsten and molybdenum, as a heating element, or the method which makes high melting point metals, such as tungsten and molybdenum, generate heat by electromagnetic induction, or what uses the furnace material made from high melting point metals, such as tungsten and molybdenum.

Even if it fires in the reduced atmosphere including hydrogen, carbon monoxide, carbon, and hydrocarbon, etc. or uses what is the method which uses carbon heating element and the firing furnace which makes carbon generate heat by electromagnetic induction, it is also effective to fire in the state where it was isolated as much as possible from the reduced atmosphere by containing the above-mentioned powder compact and sintered compact in a setter, an implement, or a saggar who do not include carbon as much as possible, such as an aluminum nitride, boron nitride, or tungsten, or embedding into an aluminum nitride powder, or embedding into an aluminum nitride powder even if it uses a setter, an implement, or a sagger who include carbon, or containing in the above setter, firing implement, or sagger and further embedding into an aluminum nitride powder, etc.

Without using the above firing method which controls the high purification of a sintered compact, if the above-mentioned powder compact or sintered compact is fired by using what is the method which uses carbon heating element or what is the method which makes carbon generate heat by electromagnetic induction or the furnace which uses the furnace material made from carbon etc., or by using a setter, an implement, or a sagger which are made from carbon, since the reduced atmosphere which contains carbon monoxide and carbon is easy to be formed spontaneously, the ingredients other than AlN evaporate and become easy to be removed, so the sintered compact which comprises an aluminum nitride as the main ingredients and has a high AlN purity and whose aluminum nitride particle grew up can be obtained easily, it is desirable.

Usually, it is desirable to fire the above-mentioned powder compact or sintered compact by using what is the method which uses carbon heating element or what is the method which makes carbon generate heat by electromagnetic induction or the furnace which uses the furnace material made from carbon etc., and using simultaneously the setter and implement, or the sagger made from carbon, in order to manufacture the sintered compact which comprises an aluminum nitride as the main ingredients and has a high AlN purity and whose aluminum nitride particle grew up.

Although the sintered compact which comprises an aluminum nitride as the main ingredients and has a high AlN purity and whose aluminum nitride particle grew up is preferred as a substrate for light emitting device mounting, even if the purity of AlN is not necessarily high, namely, even if it is the sintered compact which comprises an aluminum nitride as the main ingredients and whose ingredients, such as sintering aid, such as a rare-earth compound and an alkaline earth metal compound, or oxygen, or ingredients used as a firing temperature reduction-ized agent, such as an alkali metal and silicon, or the metal ingredients, such as Mo, W, V, Nb, Ta, and Ti, and carbon, which are used as a black-ized agent, or unescapable metal ingredients other than Mo, W, V, Nb, Ta, and Ti, or the above-mentioned metal ingredients other than aluminum and silicon, or the compound containing carbon, etc., remain much comparatively, if an aluminum nitride particle has grown up, it can become the substrate for mounting a light emitting device which comprises as the main ingredients at least one or more materials selected from a gallium nitride, an indium nitride, and an aluminum nitride.

While the above impurities remain, and even if it is the sintered compact which comprises an aluminum nitride as the main ingredients and whose aluminum nitride particle has grown, optical permeability is not insufficient or it does not restrict with a small thing, 60%-80% of high thing is also obtained as optical transmissivity of the range of 200 nm-800 nm wavelength.

Such sintered compact which comprises an aluminum nitride as the main ingredients can serve as a substrate which excelled for mounting the light emitting device that comprises as the main ingredients at least one or more materials selected from a gallium nitride, an indium nitride, and an aluminum nitride.

As for the sintered compact which comprises an aluminum nitride as the main ingredients and has such high AlN purity, or the sintered compact which comprises an aluminum nitride as the main ingredients and whose aluminum nitride particles grew up, or the sintered compact which comprises an aluminum nitride as the main ingredients and has a high AlN purity and whose aluminum nitride particles grew up, the optical transmissivity of visible light or ultraviolet light will increase.

The secondary effect whose thermal conductivity can also improve into not less than 200 W/mK or not less than 220 W/mK in room temperature is brought about.

The thermal conductivity of the sintered compact which comprises an aluminum nitride as the main ingredients originally is at least not less than 50 W/mK in room temperature, usually it is as high as not less than 100 W/mK, therefore, if the sintered compact which comprises an aluminum nitride as the main ingredients is used as a substrate for light emitting device mounting, although it has the advantage whose luminescence output of a light emitting device increases since electric power applied to a light emitting device can be enlarged, it can heighten the emitting output of a light emitting device further by raising thermal conductivity to not less than 200 W/mK in room temperature by the above methods further, for example, and is more preferred.

Moreover, as for the above-mentioned sintered compact which comprises an aluminum nitride as the main ingredients and has a high AlN purity or the sintered compact which comprises an aluminum nitride as the main ingredients and whose aluminum nitride particles grew up, since the optical transmissivity in visible light and/or the ultraviolet light of the range of 200 nm-380 nm wavelength increases and what has a comparatively high optical transmissivity not less than 20-40% is easy to be obtained, the rate whose light from a light emitting device is absorbed by a substrate decreases, and it also has another advantage whose luminous efficiency of a light emitting device increases.

In order to raise the optical transmissivity of the above-mentioned sintered compact which comprises an aluminum nitride as the main ingredients and whose high purification was attained, although the form of the powder compact and a sintered compact which are provided to firing can use any one, if it is the same volume, it is more preferred to use what has bigger surface1 area, for example, a shape of a board than a block shape, such as a cube, a rectangular parallelepiped, or a cylindrical one, etc.

If what is the one-side size of not more than 8 mm is used as the form of the powder compact and a sintered compact which are provided to the above-mentioned firing, the optical transmissivity of the sintered compact which comprises an aluminum nitride as the main ingredients and whose high purification was attained can be raised, it is desirable.

Moreover, it is more preferred to use what is the above-mentioned one side size of not more than 5 mm, it is still more preferred to use what is the one side size of not more than 2.5 mm, and it is most preferred to use what is the one side size of not more than 1 mm.

When the form of the powder compact and a sintered compact which are provided to the above-mentioned firing is board-like, it is desirable to use what is the thickness not more than 8 mm in order to raise the optical transmissivity of the sintered compact which comprises an aluminum nitride as the main ingredients and whose high purification was attained.

As for the thickness of the above-mentioned board-like powder compact and a sintered compact, it is more preferred to use what is not more than 5 mm, it is still more preferred to use what is the thickness not more than 2.5 mm, and it is most preferred to use what is the thickness not more than 1 mm.

If what was shown above is described concretely, for example, even if the sintered compact comprises the substantially same composition and substantially AlN single phase, when the sintered compact which comprises an aluminum nitride as the main ingredients and whose high purification was attained is manufactured by using what has the block-like shape such as the above-mentioned cube and rectangular parallelepiped, or the cylindrical one, or the powder compact and sintered compact which have the one side size of exceeding 8 mm, optical transmissivity lowers if it is compared with what manufactured using the compact and sintered compact which have the shape of a board or one side size of not more than 8 mm, black-ization may increase according to the case and optical transmissivity may lower further.

Although the reason is not necessarily clear, it is guessed that when ingredients other than AlN are vaporized and removed in process of the firing, the pressure of this vaporization ingredient increases and it is extracted from a sintered compact rapidly, or the minor constituent which can be hard to distinguish by X-ray diffraction or a chemical analysis changes into a reduction product, such as the nitride and carbide, etc., during vaporization of sintering aid, such as Y₂O₃ etc.

In this invention, the thickness of a substrate is usually the substrate thickness of the portion on which a light emitting device is mounted.

In the case of the substrate for light emitting device mounting which has cavity space, the substrate thickness of the side wall portion which forms cavity space is also meant.

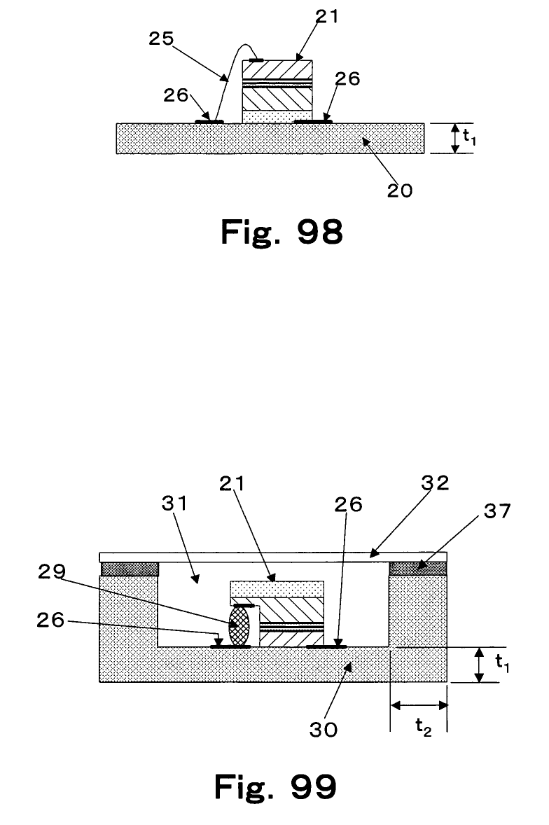

A figure (FIGS. 98 and FIG. 99) explains this.

That is, FIG. 98 is a sectional view showing an example in case substrate for light emitting device mounting is board-like.

In FIG. 98, the size shown by t1 of the portion of a substrate 20 on which the light emitting device 21 is mounted is the above-mentioned substrate thickness of the portion on which the light emitting device is mounted.

FIG. 99 is a sectional view showing an example in case substrate for light emitting device mounting has cavity space.

In FIG. 99, the size shown by t1 of the portion on which the light emitting device 21 is being mounted in the substrate 30 in which cavity space 31 is being formed is the substrate thickness of the above-mentioned portion on which the light emitting device is mounted, and the size shown by t2 of the substrate portion which forms cavity space is the substrate thickness of the side wall portion which forms cavity space.

The substrate thickness in this invention is usually what named generically these of the substrate thickness of the portion on which a light emitting device is mounted and the substrate thickness of the side wall portion which forms cavity space.

In this invention, it is preferred that it is not more than 8.0 mm as t1 and t2, respectively. By using the above illustrated method, controlling the characters of a sintered compact which comprises an aluminum nitride as the main ingredients, such as, 1) the degree of densification, 2) the quantity and size of pores, 3) the quantity and distribution of sintering aids, etc., 4) the content and an existence condition of oxygen, 5) the quantity and distribution of impurities other than sintering aids, 6) the size of aluminum nitride particle and particle size distribution, 7) the form of aluminum nitride particle, optical permeability can be raised.

As mentioned above, as for the sintered compact which was manufactured by the firing method whose ingredients other than the aluminum and nitrogen which are contained will be vaporized and removed, there is the feature that optical permeability becomes high, AlN purity also becomes high, and the size of an aluminum nitride particle also becomes large, if it is compared with what was manufactured by the usual firing method (including the above-mentioned methods, such as under decompression, under normal pressure, under pressurization atmosphere, hot press, and HIP, etc.).

Although such a sintered compact is a polycrystalline substance, since its influence of a grain boundary decreases, it approaches the quality of a single crystal.

Therefore, when this sintered compact is used as a substrate for mounting the light emitting device which comprises as the main ingredients at least one or more materials selected from a gallium nitride, an indium nitride, and an aluminum nitride, it is easy to mount that whose luminous efficiency and luminescence output were improved as this light emitting device.

This invention provides the substrate for light emitting device mounting which uses the sintered compact which comprises an aluminum nitride as the main ingredients, raised the AlN purity and is manufactured by the firing method whose high purification is the aim, or the sintered compact which comprises an aluminum nitride as the main ingredients and whose size of an aluminum nitride particle was grown up, or the sintered compact which comprises an aluminum nitride as the main ingredients and raised the AlN purity and whose size of an aluminum nitride particle was grown up.

As for the raw material powder for the manufacture of the above-mentioned sintered compact which comprises an aluminum nitride as the main ingredients, what was produced by the method of oxide reduction which reduces an aluminum oxide by carbon and is nitrided, or the direct nitriding method which nitrides metal aluminum directly, or the CVD method which decomposes aluminium compounds, such as aluminium chloride, trimethyl aluminum, and aluminum alkoxide, and is nitrided using ammonia etc. in the gaseous phase, is used.

In order to raise the transmissivity of a sintered compact, it is preferred to use the raw material which has a uniform submicron primary particle and was produced by the method of oxide reduction with chemical high purity.

Therefore, among the raw materials by the above-mentioned method, it is preferred that the thing made by the method of oxide reduction which reduces an aluminum oxide by carbon and nitrides or the thing made by the direct nitriding method which nitrides metal aluminum directly, are used alone or in the mixed state.

As for the optical transmissivity of the sintered compact which comprises an aluminum nitride as the main ingredients, what is about 60-80%, or not less than 80-90% is obtained by using the above-mentioned manufacturing process suitably.

In this invention, the sintered compact which comprises an aluminum nitride as the main ingredients and which has optical permeability is used as a substrate for mounting the light emitting device which comprises as the main ingredients at least one or more materials selected from a gallium nitride, an indium nitride, and an aluminum nitride.

As for the optical transmissivity of this sintered compact which comprises an aluminum nitride as the main ingredients, it is preferred that it is not less than 1% as mentioned above, when this sintered compact which comprises an aluminum nitride as the main ingredients is used as a substrate for light emitting device mounting, it becomes possible to emit luminescence from a light emitting device to the substrate exterior.

As for the optical transmissivity, it is more preferred that it is not less than 5%.

Using the sintered compact which comprises an aluminum nitride as the main ingredients and has such optical transmissivity as a substrate for light emitting device mounting, luminescence from a light emitting device penetrates the inside of this substrate for light emitting device mounting, it comes to be more efficiently emitted to the substrate exterior, and luminescence from this light emitting device, that penetrated the substrate is also observed clearly with the naked eye. If the optical transmissivity of the sintered compact which comprises an aluminum nitride as the main ingredients is not less than 10%, luminescence from a light emitting device will penetrate the inside of this substrate for light emitting device mounting, and will come to be more efficiently emitted to the substrate exterior, luminescence from this light emitting device that penetrated the substrate is also observed more clearly with the naked eye, further, the direction which is emitted to the substrate exterior of luminescence from the light emitting device mounted on the substrate for light emitting device mounting can be easily controlled now by using the optical permeability.

When performing direction control of luminescence from this light emitting device, it is effective to use the substrate for light emitting device mounting in which a below-mentioned reflective prevention material and a below-mentioned reflective material are formed.

In the substrate for light emitting device mounting by the sintered compact which comprises an aluminum nitride as the main ingredients, it is preferred that the optical transmissivity of this sintered compact which comprises as the main ingredients an aluminum nitride is not less than 20%, luminescence from a light emitting device penetrates the inside of this substrate for light emitting device mounting, and comes to be more efficiently emitted to the substrate exterior, luminescence from this light emitting device that penetrated the substrate is also observed clearly with the naked eye as a strong light, direction control of luminescence from the light emitting device emitted to the substrate exterior can be performed more easily now.

In the substrate for light emitting device mounting by the sintered compact which comprises an aluminum nitride as the main ingredients, it is preferred that the optical transmissivity of this sintered compact which comprises as the main ingredients an aluminum nitride is not less than 40%, luminescence from a light emitting device penetrates the inside of this substrate for light emitting device mounting, and comes to be still more efficiently emitted to the substrate exterior, luminescence from this light emitting device that penetrated the substrate is also observed more clearly with the naked eye as a strong light, direction control of luminescence from the light emitting device emitted to the substrate exterior can be performed still more easily now.

In the substrate for light emitting device mounting by the sintered compact which comprises an aluminum nitride as the main ingredients, it is preferred that the optical transmissivity of this sintered compact which comprises as the main ingredients an aluminum nitride is not less than 60%, luminescence from a light emitting device penetrates the inside of this substrate for light emitting device mounting, and comes to be still more efficiently emitted to the substrate exterior, luminescence from this light emitting device that penetrated the substrate is also observed more clearly with the naked eye as a strong light, direction control of luminescence from the light emitting device emitted to the substrate exterior can be performed still more easily now. In the substrate for light emitting device mounting by the sintered compact which comprises an aluminum nitride as the main ingredients, it is preferred that the optical transmissivity of this sintered compact which comprises as the main ingredients an aluminum nitride is not less than 80%, luminescence from a light emitting device penetrates the inside of this substrate for light emitting device mounting, and comes to be still more efficiently emitted to the substrate exterior, luminescence from this light emitting device that penetrated the substrate is also observed more clearly with the naked eye as a strong light, direction control of luminescence from the light emitting device emitted to the substrate exterior can be performed still more easily now.

In the substrate for light emitting device mounting by the sintered compact which comprises an aluminum nitride as the main ingredients, it is preferred that the optical transmissivity of this sintered compact which comprises as the main ingredients an aluminum nitride is not less than 85%, luminescence from a light emitting device penetrates the inside of this substrate for light emitting device mounting, and comes to be most efficiently emitted to the substrate exterior, luminescence from this light emitting device that penetrated the substrate is also observed more clearly with the naked eye as a strong light, direction control of luminescence from the light emitting device emitted to the substrate exterior can be performed most easily now.

Although the above-mentioned optical transmissivity is usually measured by monochromatic light with a wavelength 605 nm, the sintered compact which comprises an aluminum nitride as the main ingredients and which has the optical transmissivity measured by this method has the same transmissivity also in all the visible light areas of the range of 380 nm-800 nm wavelength.

The sintered compact which comprises an aluminum nitride as the main ingredients and has such optical transmissivity of visible light has high transmissivity also to the light of the ultraviolet region of the range of 200 nm-380 nm wavelength.

In this invention, since substrate for light emitting device mounting is a sintered compact which comprises an aluminum nitride as the main ingredients and which has optical permeability, it is the polycrystalline substance whose crystal direction of the aluminum nitride particle in a sintered compactof is to the random direction.

Therefore, luminescence from the light emitting device which penetrated the inside of this above-mentioned sintered compact which comprises an aluminum nitride as the main ingredients hardly becomes into going-straight light, but was scattered about by the aluminum nitride particle in a sintered compact, and is emitted to the substrate exterior.

This inventor confirmed that by using the above-mentioned sintered compact which comprises an aluminum nitride as the main ingredients for light emitting device mounting, when luminescence from the light emitting device which comprises as the main ingredients at least one or more materials selected from a gallium nitride, an indium nitride, and an aluminum nitride and is mounted on this substrate penetrates this substrate and is emitted to the substrate exterior, although this emitted light is a strong light, unlike going-straight light which penetrated transparent glass, resin, etc. and pierces the eye, it is quiet and tends to become into a light gentle to man's eyes.

If the optical transmissivity of the sintered compact which comprises an aluminum nitride as the main ingredients is high, the light which penetrated the substrate for light emitting device mounting using the sintered compact according to this invention which comprises an aluminum nitride as the main ingredients will tend to become quiet and brighter.

In the substrate for light emitting device mounting according to this invention, what contains an aluminum nitride not less than 50 volume % as the sintered compact which comprises an aluminum nitride as the main ingredients tends to obtain what has good optical permeability.

If the sintered compact which comprises an aluminum nitride as the main ingredients and contains an aluminum nitride not less than 50 volume % is used as a substrate for mounting the light emitting device which comprises as the main ingredients at least one or more materials selected from a gallium nitride, an indium nitride, and an aluminum nitride, luminescence from this light emitting device can be efficiently emitted now to the substrate exterior.

It becomes possible to control the direction of this luminescence.

The content of the aluminum nitride in the substrate which consists of a sintered compact which comprises an aluminum nitride as the main ingredients is easily reckonable by carrying out the element conversion or oxide conversion of the content of ingredients contained in a sintered compact other than aluminum and nitrogen, such as a rare earth element, an alkaline-earth-metal, oxygen, an alkaline metal, a silicon ingredient, metal ingredients, such as Mo, W, V, Nb, Ta, Ti, carbon, or unescapable impurities of transition metals other than metal ingredients of Mo, W, V, Nb, Ta, and Ti, and ALON, etc., respectively.

In this invention, the above-mentioned content of rare earth element, alkaline-earth metal, alkaline metal, and silicon which are contained in the sintered compact which comprises an aluminum nitride as the main ingredients was calculated by oxide conversion.

About the above-mentioned oxygen, metal ingredients, such as Mo, W, V, Nb, Ta, Ti, carbon or unescapable impurities of transition metals other than metal ingredients, such as Mo, W, V, Nb, Ta, and Ti, it asked by element conversion.

In this invention, each above-mentioned content of ingredients other than aluminum and nitrogen of the sintered compact which comprises an aluminum nitride as the main ingredients was calculated by either volume percent (volume %) or weight percentage (weight %).

As for the calculation method of volume percent, it can ask for ingredients other than the aluminum contained and nitrogen by weight percentage by oxide conversion or element conversion, and can ask easily by calculating from the density of these oxides or an element.

The content of ALON was calculated by the method of comparing the strongest line of ALON with the strongest line of AlN by X ray diffraction, so that it may state separately below.

The optical transmissivity of a sintered compact which comprises an aluminum nitride as the main ingredients changes by the factors, such as 1) density of a sintered compact, 2) existence and size of the pore inside a sintered compact, 3) content of the sintering aid or black-ized agent of a sintered compact, 4) oxygen content of a sintered compact, 5) impurity content other than oxygen and sintering aid of a sintered compact, 6) size of the aluminum nitride particle in a sintered compact, 7) form of the aluminum nitride particle in a sintered compact, but the sintered compact which comprises an aluminum nitride as the main ingredients and has optical permeability and which can be used for the substrate for light emitting device mounting according to this invention by controlling each factor which affects the optical transmissivity of the above-mentioned sintered compact can be manufactured.

In this invention, it is preferred to use the sintered compact which comprises an aluminum nitride as the main ingredients and which has optical permeability as a substrate for light emitting device mounting.

As for the optical transmissivity, it is preferred that it is not less than 1%.

This inventor investigated in more detail below about each above-mentioned factor which gives to the optical permeability of the sintered compact which comprises an aluminum nitride as the main ingredients and is used as a substrate for light emitting device mounting.

As for the density of the sintered compact which comprises an aluminum nitride as the main ingredients, if it is not in the state in which an aluminum nitride particle, sintering aids, etc. were densely packed in the sintered compact, what optical permeability will not increase can be guessed easily.

In the substrate for light emitting device mounting according to this invention, in order to obtain the sintered compact of optical permeability which comprises an aluminum nitride as the main ingredients, as for the relative density of this sintered compact which comprises an aluminum nitride as the main ingredients, it is preferred that it is not less than 95%, and the sintered compact which comprises an aluminum nitride as the main ingredients and has the optical transmissivity not less than 1% is easy to be obtained.

In the substrate for light emitting device mounting according to this invention, if the relative density of the sintered compact which comprises an aluminum nitride as the main ingredients is not less than 98%, the sintered compact which comprises an aluminum nitride as the main ingredients and has the optical transmissivity not less than 5% is easy to be obtained.

In the substrate for light emitting device mounting according to this invention, if the relative density of the sintered compact which comprises an aluminum nitride as the main ingredients is not less than 99%, the sintered compact which comprises an aluminum nitride as the main ingredients and has the optical transmissivity not less than 10% is easy to be obtained.

In the substrate for light emitting device mounting according to this invention, if the relative density of the sintered compact which comprises an aluminum nitride as the main ingredients is not less than 99.5%, the sintered compact which comprises an aluminum nitride as the main ingredients and has the optical transmissivity not less than 20% is easy to be obtained.

In this invention, although relative density is what is to the theoretical density of an aluminum nitride (3.261 g/cm³) in the sintered compact which comprises an aluminum nitride as the main ingredients and produced without adding additives, such as sintering aid and a black-ized agent, in the case of the sintered compact which comprises an aluminum nitride as the main ingredients and produced by adding additives, such as sintering aid and a black-ized agent, it is not to the theoretical density of an aluminum nitride, but it was shown by the density of the calculated value when considering that ingredients, such as an aluminum nitride and sintering aids, are only being mixed.

Therefore, as for the relative density of the sintered compact which comprises an aluminum nitride as the main ingredients, it depends on sintered compact composition.

Concretely speaking, in the sintered compact which comprises an aluminum nitride as the main ingredients and contains an aluminum nitride (AlN) 95 weight % and a yttrium oxide (Y₂O₃) 5 weight %, since the density of AlN is 3.261 g/cm³ and the density of Y₂O₃ is 5.03 g/cm³, when the complete densification of the sintered compact of this composition is attained, 3.319 g/cm³ of the density is calculated, the percentage of the density of the actually obtained sintered compact and the above-mentioned density by calculation becomes the relative density said in this invention.

If an example is furthermore shown, in the sintered compact which comprises an aluminum nitride as the main ingredients and contains an aluminum nitride (AlN) 90 weight % and an erbium oxide (Er₂O₃) 10 weight %, since the density of Er₂O₃ is 8.64 g/cm³, when the complete densification of the sintered compact of this composition is attained, 3.477 g/cm³ of the density is calculated, the percentage of the density of the actually obtained sintered compact and the above-mentioned density by calculation becomes relative density said in this invention.

In the sintered compact which comprises an aluminum nitride as the main ingredients and contains an aluminum nitride (AlN) 99.5 weight % and a calcium oxide (CaO) 0.5 weight %, since the density of CaO is 3.25 g/cm³, when the complete densification of the sintered compact is attained, 3.261 g/cm³ of the density is calculated, the percentage of the density of the actually obtained sintered compact and this density by calculation becomes relative density said in this invention.

In the sintered compact which comprises an aluminum nitride as the main ingredients and has the relative density of the above range and which uses as a substrate for light emitting device mounting according to this invention, what has the optical transmissivity still higher than what was shown above is obtained, what has the optical transmissivity of a maximum of not less than 80%-85% is obtained.

If the size of the pore inside the sintered compact which comprises an aluminum nitride as the main ingredients is small, it can also guess easily that optical transmissivity will become high.

Actually, in the substrate for light emitting device mounting according to this invention, if the pore size of a sintered compact which comprises an aluminum nitride as the main ingredients is an average of not more than 1 μm, what is not less than 5% is easy to be obtained as optical transmissivity of the sintered compact which comprises an aluminum nitride as the main ingredients.

If the pore size is an average of not more than 0.7 μm, what is not less than 10% is easy to be obtained as optical transmissivity of the sintered compact which comprises an aluminum nitride as the main ingredients.

If the pore size is an average of not more than 0.5 μm, what is not less than 20% is easy to be obtained as optical transmissivity of the sintered compact which comprises an aluminum nitride as the main ingredients.

In the sintered compact which comprises an aluminum nitride as the main ingredients and has the average pore size of the above range and which is used as a substrate for light emitting device mounting according to this invention, what has the optical transmissivity still higher than what was shown above is obtained, and what has the optical transmissivity of a maximum of not less than 80%-85% is obtained.

As mentioned above, the sintered compact which comprises an aluminum nitride as the main ingredients and has high relative density and whose average size of a pore is small tends to have optical high transmissivity.

Relative density of a sintered compact and quantity of the pore contained in a sintered compact has a reverse relation.

In other words, If the relative density of the sintered compact which comprises an aluminum nitride as the main ingredients becomes high, it means that the quantity of the pore contained in a sintered compact becomes small.

That is, in the substrate for light emitting device mounting according to this invention, it is preferred that the porosity of the sintered compact which comprises an aluminum nitride as the main ingredients is not more than 5%, and the sintered compact of transmissivity not less than 1% which comprises an aluminum nitride as the main ingredients is easy to be obtained.

In the substrate for light emitting device mounting according to this invention, if the porosity of the sintered compact which comprises an aluminum nitride as the main ingredients is not more than 2%, the sintered compact which comprises an aluminum nitride as the main ingredients and which is the optical transmissivity not less than 5% is easy to be obtained.

In the substrate for light emitting device mounting according to this invention, if the porosity of the sintered compact which comprises an aluminum nitride as the main ingredients is not more than 1%, the sintered compact which comprises an aluminum nitride as the main ingredients and which is the optical transmissivity not less than 10% is easy to be obtained.

In the substrate for light emitting device mounting according to this invention, if the porosity of the sintered compact which comprises an aluminum nitride as the main ingredients is not more than 0.5%, the sintered compact which comprises an aluminum nitride as the main ingredients and which is the optical transmissivity not less than 20% is easy to be obtained.

In the sintered compact which comprises an aluminum nitride as the main ingredients and has the porosity of the above range and which is used as a substrate for light emitting device mounting according to this invention, what has the optical transmissivity still higher than what was shown above is obtained, what has the optical transmissivity of a maximum of not less than 80% -85% is obtained.

In order to improve the above-mentioned sintered compact density, and to reduce the internal pore of a sintered compact or to make the size of an inside pore small, the following methods are effective, for example.

That is, (1) uses that whose primary particle of a grain size is submicron and whose distribution is uniform, as a raw material for sintered compact manufacture, (2) lowers the firing temperature and controls the grain growth, (3) performs the atmospheric pressure sintering and the hot press or HIP under the higher condition than 1 atmospheric pressure, (4) performs holding temperature in many stages in firing, (5) performs by combining the decompression firing or normal pressure sintering with the firing under an atmosphere higher than 1 atmospheric pressure, such as atmospheric pressure sintering, hot press, or HIP, etc.

It is also effective to carry out combining the above-mentioned method two or more.

In the substrate for light emitting device mounting according to this invention, the sintered compact which comprises an aluminum nitride as the main ingredients can use as sintering aid other than aluminum nitride which is a main ingredient, for example, what contains rare-earth oxides, such as Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, Lu₂O₃, in addition to this, what contains rare-earth element, such as Sc, Y, La, Ce, Pr, Nd, Pm, Sm, Eu, Gd, Tb, Dy, Ho, Er, Tm, Yb, and Lu, etc., or what contains inorganic rare earth compounds, such as carbonate, cnitrate, sulfate, and chloride, containing such as Sc, Y, La, Ce, Pr, Nd, Pm, Sm, Eu, Gd, Tb, Dy, Ho, Er, Tm, Yb, Lu, etc., and various rare-earth compounds, such as organic rare earth compounds, such as acetate, oxalate, and citrate, alkaline earth metal oxides, such as BeO, MgO, CaO, SrO, and BaO, or other alkaline earth metal, such as Be, Mg, Ca, Sr, and Ba, or inorganic alkaline earth metal compounds, such as carbonate, nitrate, sulfate, and chloride, etc. containing Be, Mg, Ca, Sr, Ba, etc., various alkaline earth metal compounds, such as organoalkaline earth metal compounds, such as acetate, oxalate, and citrate, what simultaneously contains a rare-earth compound and an alkaline earth metal compound for the performing of firing temperature lowering, what contains alkali metal compounds, such as Li₂O, Li₂CO₃, LiF, LiOH, Na₂O, Na₂CO₃, NaF, NaOH, K₂O, K₂CO₃, KF, and KOH, and compounds containing silicon, such as Si, SiO₂, Si₃N₄, and SiC, what contains metals, alloy, and metallic compound containing Mo (molybdenum), W (tungsten), V (vanadium), Nb (niobium), Ta (tantalum), and Ti (titanium), etc., and carbon in order to achieve black-ization.

It can guess easily that these sintering aids, firing temperature reduction-ized agents, and black-ized agents also affect the optical transmissivity of a sintered compact.

In the substrate for light emitting device mounting according to this invention, as for the sintered compact which comprises an aluminum nitride as the main ingredients, by using the thing in which the content of at least one or more materials selected from these is not more than 30 volume % by oxide conversion if ingredients other than the aluminum nitride which is a main ingredient are a rare earth element and an alkaline-earth metal, by using the thing in which the content of at least one or more compounds selected from these ingredients is not more than 5 volume % by oxide conversion if it is an alkaline metal and silicon, and by using what contains at least one or more ingredients selected from the above-mentioned ingredient not more than 5 volume % by element conversion for achieving the black-ization if it is the above-mentioned ingredient for achieving the black-ization, the sintered compact which comprises an aluminum nitride as the main ingredients and has the optical transmissivity not less than 1% at least can be obtained now.

Luminescence from this light emitting device can be efficiently emitted now to the substrate exterior using such sintered compact which comprises an aluminum nitride as the main ingredients and contains ingredients other than aluminum nitride as a substrate to mount a light emitting device which comprises as the main ingredients at least one or more materials selected from a gallium nitride, an indium nitride, and an aluminum nitride.

It becomes possible to control the direction of this luminescence.

The above-mentioned sintering aids, the firing temperature reduction-ized agents, and the black-ized agents tend to produce the different compound and different crystal phase from an aluminum nitride inside a sintered compact.

It is guessed that the compound or crystal phase generated by the above-mentioned sintering aids, firing temperature reduction-ized agents, and black-ized agents, and the amount of existence of this compound or a crystal phase affect the optical permeability of the sintered compact which comprises an aluminum nitride as the main ingredients.

Each element ingredient other than the aluminum nitride contained in the sintered compact which comprises an aluminum nitride as the main ingredients and is a substrate for light emitting device mounting is converted into an oxide, and it is calculated from the density and the weight percent of this oxide as the above-mentioned volume % (volume percentage) of the sintering aids, the firing temperature reduction-ized agents, and the black-ized agents in the sintered compact which comprises an aluminum nitride as the main ingredients.

For example, although it does not mean the volume percent of the reactant which arises actually by the mutual reaction of each element ingredient other than an aluminum nitride contained in the above-mentioned substrate or by the reaction with unescapable mixing ingredients, such as oxygen and a transition metal etc., it can be the scale which measures the densification degree of a sintered compact.

Concretely speaking, in the sintered compact which comprises an aluminum nitride as the main ingredients and contains aluminum nitride (AlN) 95 weight % and yttrium oxide (Y₂O₃) 5 weight %, since the density of AlN is 3.261 g/cm³ and the density of Y₂O₃ is 5.03 g/cm³, it is calculated that the content of a rare-earth compound is 3.30 volume %.

In the sintered compact which comprises an aluminum nitride as the main ingredients and contains aluminum nitride (AlN) 90 weight % and erbium oxide (Er₂O₃) 10 weight %, since the density of Er₂O₃ is 8.64 g/cm³, it is calculated that the content of a rare-earth compound is 4.02 volume %.

In the sintered compact which comprises an aluminum nitride as the main ingredients and contains aluminum nitride (AlN) 99.5 weight % and calcium carbonate (CaCO₃) 0.5 weight % by calcium oxide (CaO) conversion, since the density of CaO is 3.25 g/cm³, it is calculated that the content of an alkaline earth metal compound is 0.50 volume %.

For example, in the sintered compact which comprises an aluminum nitride as the main ingredients and contains aluminum nitride (AlN) 99 weight % and molybdenum (Mo) 1 weight %, since the density of AlN is 3.261 g/cm³ and the density of Mo is 10.2 g/cm³, it is calculated that the content of molybdenum is 0.32 volume %.

In the sintered compact which comprises an aluminum nitride as the main ingredients and contains aluminum nitride (AlN) 90 weight % and tungsten (W) 10 weight %, since the density of W is 19.1 g/cm³, it is calculated that the content of a rare-earth compound is 1.86 volume %.

The substrate for light emitting device mounting according to this invention contains not only the above-mentioned ingredient as the sintering aids, ingredient for achieving black-ization, and ingredient for attaining reduction-ization of firing temperature but also the unescapable impurities ingredient of the transition metal which is contained in the raw material for sintered compact manufacture and is easy to mix from a manufacturing process other than aluminum nitride which is a main ingredient.

Such unescapable impurities are what contains transition metals other than a rare earth element and Mo, W, V, Nb, Ta, and Ti, for example, such as, iron, nickel, chromium, manganese, zirconium, hafnium, cobalt, copper, and zinc ingredients, etc.

Usually unless reference is made especially in this invention, the above “unescapable impurities ingredient of a transition metal” means iron, nickel, chromium, manganese, zirconium, hafnium, cobalt, copper, and zinc.

“Containing the unescapable impurities ingredient of a transition metal” means that at least one or more of each ingredient, such as the above-mentioned iron, nickel, chromium, manganese, zirconium, hafnium, cobalt, copper, and zinc, are contained.

In the above-mentioned substrate for mounting the light emitting device which comprises as the main ingredients at least one or more materials selected from a gallium nitride, an indium nitride, and an aluminum nitride, as for the content of unescapable impurities ingredients, such as the above-mentioned transition metal contained in the sintered compact which comprises an aluminum nitride as the main ingredients, it is preferred that it is not more than 1 weight % by element conversion, the sintered compact which comprises an aluminum nitride as the main ingredients and is the optical transmissivity not less than 1% can be easy to obtain by using the substrate of this unescapable impurities amount.

In the substrate for light emitting device mounting according to this invention, as for the content of the above-mentioned unescapable impurities ingredients, such as a transition metal contained in the sintered compact which comprises an aluminum nitride as the main ingredients, it is more preferred that it is not more than 0.5 weight % by element conversion, the sintered compact which comprises an aluminum nitride as the main ingredients and is the optical transmissivity not less than 5% can be easy to obtain by using the substrate of this unescapable impurities amount.

In the substrate for light emitting device mounting according to this invention, as for the content of the above-mentioned unescapable impurities ingredients, such as a transition metal contained in the sintered compact which comprises an aluminum nitride as the main ingredients, it is more preferred that it is not more than 0.2 weight % by element conversion, the sintered compact which comprises an aluminum nitride as the main ingredients and is the optical transmissivity not less than 10% can be easy to obtain by using the substrate of this unescapable impurities amount.

Furthermore, in the substrate for light emitting device mounting according to this invention, as for the content of the above-mentioned unescapable impurities ingredients, such as a transition metal contained in the sintered compact which comprises an aluminum nitride as the main ingredients, it is more preferred that it is not more than 0.05 weight % by element conversion, the sintered compact which comprises an aluminum nitride as the main ingredients and is the optical transmissivity not less than 20% can be easy to obtain by using the substrate of this unescapable impurities amount.

When manufacturing the sintered compact which comprises an aluminum nitride as the main ingredients, mixing of unescapable impurities can be decreased with the device of achieving high purity-ization of the material used for the portion where ceramics contact using a high purity raw material in manufacturing processes, such as the manufacture of a green sheet and a granule for powder pressing, or the firing.

In the sintered compact which comprises an aluminum nitride as the main ingredients and contains alkaline-earth-metals compound of the above range and which uses as a substrate for light emitting device mounting according to this invention, what has the optical transmissivity still higher than what was shown above is obtained, what has the optical transmissivity of a maximum of not less than 80%-85% is obtained.

The substrate for light emitting device mounting according to this invention which consists of a sintered compact which comprises an aluminum nitride as the main ingredients and which has optical permeability contains not only the above-mentioned ingredient as sintering aids, ingredient for achieving black-ization, ingredient for attaining reduction-ization of firing temperature, and unescapable metal impurities ingredients but also the oxygen which is contained in the raw material for sintered compact manufacture and is further mixed from a manufacturing process other than aluminum nitride which is a main ingredient.

Oxygen is usually contained about 0.01 to 5.0 weight % in the raw material for sintered compact manufacture, although it vaporizes in part during firing, it is almost incorporated into a sintered compact as it is in many case, and ALON (aluminum oxynitride: the compound between AlN and Al₂O₃) of a spinel type crystal structure is generated in the sintered compact manufactured without using sintering aids etc. in many case.

This ALON shows the diffraction line usually shown in the JCPDS file number 36-50.

Oxygen is contained by adding Al₂O₃ positively so that ALON may be generated in a sintered compact again.

Furthermore, part of these is also contained when sintering aids and a black-ized agents are the compounds containing oxygen, such as an oxide and a compound oxide.

If there are more amounts of oxygen in a sintered compact than 10 weight %, generation of compounds, such as ALON, or between sintering aid and oxygen, or between black-ized agent and oxygen, between a firing temperature reduction-ized agent and oxygen, etc., will increase inside a sintered compact which comprises an aluminum nitride as the main ingredients, and it will be easy to bring about the lowering of the crystallinity of a single crystal thin film.

Although the amount of generation of ALON in the inside of a sintered compact is controllable by the amount of oxygen and the amount of sintering aids, such as a rare-earth compound and an alkaline earth metal compound, when not using sintering aids, it is dependent only on the amount of oxygen in a sintered compact.

In the substrate for light emitting device mounting according to this invention, if the content of ALON of the sintered compact which comprises an aluminum nitride as the main ingredients is not more than 12%, since what is the optical transmissivity not less than 5% is easy to be obtained, it is preferred.

In the substrate for light emitting device mounting according to this invention, if the content of ALON of the sintered compact which comprises an aluminum nitride as the main ingredients is not more than 7%, since what is the optical transmissivity not less than 10% is easy to be obtained, it is more desirable.

The content of ALON of the sintered compact which comprises an aluminum nitride as the main ingredients asks for the ratio of the diffraction line intensity from the Miller Index (311) lattice plane of ALON and the diffraction line intensity from the Miller Index (100) lattice plane of AlN by percentage according to performing the X-ray diffraction on the surface of a substrate of this sintered compact which comprises an aluminum nitride as the main ingredients.

In the inside of a sintered compact which comprises an aluminum nitride as the main ingredients, what is the amount of ALON not more than 12% is easy to be formed in what is the amount of oxygen not more than 5.0 weight % in the sintered compact which is fired only with aluminum nitride raw material powder or only with the mixed powder of this raw material powder and Al₂O₃ without using additives, such as sintering aid.

What is the amount of ALON not more than 7% is easy to be formed by what is the amount of oxygen not more than 3.0 weight % in the sintered compact which is fired only with aluminum nitride raw material powder or only with the mixed powder of this raw material powder and Al₂O₃ without using additives, such as sintering aid.

In the substrate for light emitting device mounting according to this invention, in that whose quantity of ALON in the sintered compact which comprises an aluminum nitride as the main ingredients is not more than 20%, since what is the optical transmissivity not less than 1% is easy to be obtained, it is preferred.

In the inside of a sintered compact which comprises an aluminum nitride as the main ingredients, what is the amount of ALON not more than 20% is easy to be formed by what is the amount of oxygen not more than 10.0 weight % in the sintered compact which is fired only with aluminum nitride raw material powder or only with the mixed powder of this raw material powder and Al₂O₃ without using additives, such as sintering aid.

When ALON is generating more than 20% in the sintered compact which comprises an aluminum nitride as the main ingredients, the optical transmissivity of this sintered compact which comprises an aluminum nitride as the main ingredients lowers, when this sintered compact which comprises an aluminum nitride as the main ingredients and whose optical transmissivity fell is used as a substrate for light emitting device mounting, since luminescence from a light emitting device becomes hard to be emitted to the substrate exterior efficiently enough, it is not preferred.

Thus, if the quantity of ALON increases in the sintered compact which comprises an aluminum nitride as the main ingredients, the optical transmissivity of this sintered compact which comprises an aluminum nitride as the main ingredients will become easy to lower.

As the reason, this inventor is guessing that since an ALON crystal is the spinel type whose crystal system differs from the wurtzite type crystal of AlN, when luminescence from a light emitting device is irradiated inside a sintered compact, in the inside of a sintered compact, light scattering increases between the ALON particles and the particles which have a different crystal system of the aluminum nitride particle, light stops being able to penetrate a substrate easily as a result.

In the sintered compact according to this invention which comprises an aluminum nitride as the main ingredients and contains ALON of the above range and which is used as a substrate for light emitting device mounting, what has the optical transmissivity still higher than what was shown above is obtained, what has the optical transmissivity of a maximum of not less than 80%-85% is obtained.

In this invention, in the substrate which consists of a sintered compact which comprises an aluminum nitride as the main ingredients and which has optical permeability, even if it is what sintered the aluminum nitride particle in a sintered compact in the same condition as the size of the particle of raw material powder without making it grow up with about an average of 0.5 μm, what has optical permeability is obtained and it can be used as a substrate for light emitting device mounting.

On the other hand, in the sintered compact which comprises an aluminum nitride as the main ingredients, since the optical permeability of this sintered compact which comprises an aluminum nitride as the main ingredients will become easy to improve if the size of an aluminum nitride particle contained inside this sintered compact increases, this sintered compact which comprises an aluminum nitride as the main ingredients can be suitably used as a substrate for light emitting device mounting.

In the substrate for light emitting device mounting according to this invention, if the size of an aluminum nitride particle contained inside the sintered compact which comprises an aluminum nitride as the main ingredients is an average of not less than 1 μm, what is not less than 1% is easy to be obtained as optical transmissivity of the sintered compact which comprises an aluminum nitride as the main ingredients.

In the substrate for light emitting device mounting according to this invention, in the sintered compact which comprises an aluminum nitride as the main ingredients and whose size of an aluminum nitride particle is an average of not less than 5 μm, what is not less than 5% is easy to be obtained as optical transmissivity of the sintered compact which comprises an aluminum nitride as the main ingredients.

In the substrate for light emitting device mounting according to this invention, in the sintered compact which comprises an aluminum nitride as the main ingredients and whose size of an aluminum nitride particle is an average of not less than 8 μm, what is not less than 10% is easy to be obtained as optical transmissivity of the sintered compact which comprises an aluminum nitride as the main ingredients.

In the substrate for light emitting device mounting according to this invention, in the sintered compact which comprises an aluminum nitride as the main ingredients and whose size of an aluminum nitride particle is an average of not less than 15 μm, what is not less than 20% is easy to be obtained as optical transmissivity of the sintered compact which comprises an aluminum nitride as the main ingredients.

In the substrate for light emitting device mounting according to this invention, in the sintered compact which comprises an aluminum nitride as the main ingredients and whose size of an aluminum nitride particle is an average of not less than 25 μm, what is not less than 30% is easy to be obtained as optical transmissivity of the sintered compact which comprises an aluminum nitride as the main ingredients.

That is, it is surmised that if the size of an aluminum nitride particle inside the sintered compact which comprises an aluminum nitride as the main ingredients becomes large, since the area of the grain boundary of an aluminum nitride crystal grain will decrease and the influence of a grain boundary will decrease the character of the aluminum nitride crystal grain itself becomes easy to be revealed, the optical transmissivity will become easy to improve as a result.

Usually, the above effect of enlarging the aluminum nitride particles is seen even if it is the substrate for light emitting device mounting which consists of a sintered compact of what kind of composition which comprises an aluminum nitride as the main ingredients.

As the example of such a sintered compact which comprises an aluminum nitride as the main ingredients, it is what contains the above-mentioned oxygen, or ingredients used as a sintering aid, such as a rare-earth compound or an alkaline earth metal compound, etc., or ingredients used as a firing temperature reduction-ized agent, such as an alkali metal and silicon, etc. or metal ingredients used as a black-ized agent, such as Mo, W, V, Nb, Ta, Ti, etc., or carbon, or the unescapable metal ingredients other than Mo, W, V, Nb, Ta, and Ti, etc., and further ALON etc. as a crystal phase.

And, as the example of such a sintered compact which comprises an aluminum nitride as the main ingredients, the sintered compact which is manufactured without adding sintering aids to raw material powder and does not contain substantially sintering aids, such as a rare earth element or an alkaline-earth metal, is also included.

In the substrate which consists of a sintered compact which comprises an aluminum nitride as the main ingredients and was illustrated above, the optical permeability of the sintered compact which comprises an aluminum nitride as the main ingredients becomes easy to improve by increasing the size of an aluminum nitride particle.

Although the effect of making the size of an aluminum nitride particle in the sintered compact which comprises an aluminum nitride as the main ingredients increase is described in detail also later, what has higher optical permeability is obtained by using the sintered compact which comprises an aluminum nitride as the main ingredients and raised AlN purity, and this sintered compact can be used still more suitably as a substrate for light emitting device mounting.

In the sintered compact which comprises an aluminum nitride as the main ingredients and has the average size of an aluminum nitride particle of the above range and which is used as a substrate for light emitting device mounting according to this invention, what has the optical transmissivity still higher than what was shown above is obtained, what has the optical transmissivity of a maximum of not less than 80%-85% is obtained.

Although the above effect of enlarging the aluminum nitride particles is seen usually even if it is the substrate which consists of a sintered compact of what kind of composition which comprises an aluminum nitride as the main ingredients, the degree of an effect tends to decrease as the content of AlN in a sintered compact decreases.

In the substrate for light emitting device mounting according to this invention, if the content of AlN of the sintered compact which comprises an aluminum nitride as the main ingredients is not less than 50 volume %, the sintered compact which comprises an aluminum nitride as the main ingredients and has the optical transmissivity not less than 1% is easy to be obtained.

In order to make the above effect of enlarging the aluminum nitride particles easy to generate, it is desirable that it is not less than 70 volume % as the content of AlN in the substrate for light emitting device mounting which consists of a sintered compact which comprises an aluminum nitride as the main ingredients.

In the substrate for light emitting device mounting according to this invention, if it is the sintered compact which comprises an aluminum nitride as the main ingredients and is not less than 70 volume % of the AlN content, the sintered compact which comprises an aluminum nitride as the main ingredients and has the optical transmissivity not less than 5% is easy to be obtained. In the sintered compact which comprises an aluminum nitride as the main ingredients and has the AlN content of the above range and which is used as a substrate for light emitting device mounting according to this invention, what has the optical transmissivity still higher than what was shown above is obtained, what has the optical transmissivity of a maximum of not less than 80%-85% is obtained.

In order to make the size of the aluminum nitride particle in a sintered compact which comprises an aluminum nitride as the main ingredients increase, it is effective usually to raise firing temperature or to lengthen firing time.

In order to control the size of an aluminum nitride particle, although it is easy to be dependent also on the origin and the grain size of raw material powder of an aluminum nitride, or the composition of the compact or sintered compact, according to this invention, by firing for comparatively long time not less than 3 hours at the temperature not less than 1750 degrees C., the sintered compact which comprises an aluminum nitride as the main ingredients and has aluminum nitride particle of an average of not less than 5 μm is easy to be obtained.

In order to obtain the sintered compact of the aluminum nitride particle which has an average of not less than 8 μm, it is preferred to perform the firing for not less than 10 hours at the temperature not less than 1750 degrees C., for not less than 3 hours at the temperature not less than 1900 degrees C.

In order to obtain the sintered compact of the aluminum nitride particle which has an average of not less than 15 μm, it is preferred to perform the firing for not less than 6 hours at the temperature not less than 1900 degrees C., for not less than 3 hours at the temperature not less than 2050 degrees C.

In order to obtain the sintered compact of the aluminum nitride particle which has an average of not less than 25 μm, it is preferred to perform the firing for not less than 4 hours at the temperature not less than 2050 degrees C., for not less than 3 hours at the temperature not less than 2100 degrees C.

In such firing, in order to obtain the sintered compact which comprises an aluminum nitride as the main ingredients and is the state where the size of an aluminum nitride particle is only increasing, the vaporization and removal of an ingredient, such as oxygen, or the ingredients used as sintering aid, such as a rare-earth compound or an alkaline earth metal compound, etc., or the ingredients used as a firing temperature reduction-ized agent, such as an alkali metal and silicon, etc. or the meta ingredients used as a black-ized agent, such as Mo, W, V, Nb, Ta, Ti, etc., or carbon, or the unescapable metal ingredients other than Mo, W, V, Nb, Ta, and Ti, etc., were controlled, and further ALON etc. was contained as a crystal phase contained, it is preferred to use non-oxidizing atmosphere, such as nitrogen and argon, etc., which has comparatively little of reduction nature ingredients, as described above.

On the other hand, in order to obtain the sintered compact which comprises an aluminum nitride as the main ingredients and whose size of an aluminum nitride particle was increased and whose AlN purity improved, it is preferred to fire in the non-oxidizing atmosphere containing reduction nature ingredients, such as hydrogen, carbon monoxide, carbon, and hydrocarbon.

In the substrate for light emitting device mounting according to this invention, as for the form of the aluminum nitride particle contained inside a sintered compact, what is a polygonal and that whose overlap in each surface and ridgeline, or at a polygonal vertex is tight is more preferable than the round thing in which the edge of a particle was smoothed out in oeder to make the optical transmissivity of a sintered compact not less than 1%.

That is, if the form of an aluminum nitride particle is a round thing whose edge was smoothed out, since the sintered compact particles cannot unite together without a space in the inside of a sintered compact, the grain boundary phase which consists of ingredients other than an aluminum nitride tends to intervene, the transmissivity of a sintered compact lowers according to these grain boundary phase, it is surmised furthermore that it will be because it will be for making irregular the direction of the nuclear growth of the single crystal thin film which comprises as the main ingredients at least one or more materials selected from a gallium nitride, an indium nitride, and an aluminum nitride which are beginning to grow.

The roundish particles of a sintered compact are seen when the above-mentioned sintering aids and firing temperature reduction-ized agents are usually contained superfluously.

That is, since the superfluous liquid phase is generated by the superfluous sintering aid in firing, and a sintered compact particle grows in the liquid phase it is easy to be roundish.

That a sintered compact particle becomes easy to be roundish means being easy to be generated when sintering aids, such as the above-mentioned rare-earth compound and an alkaline earth metal element compound, and firing temperature reduction-ized agents, such as an alkali metal compound, and a silicon compound, etc., are contained more than the range shown above.

In the raw material powder for manufacturing the sintered compact which comprises an aluminum nitride as the main ingredients and is used as the above-mentioned substrate light emitting device mounting, oxygen is usually included about 0.01 weight %-5.0 weight % in addition to an AlN ingredient.

In the substrate for light emitting device mounting according to this invention, as for the content of a rare earth element contained in the above-mentioned sintered compact which comprises an aluminum nitride as the main ingredients, it is preferred that it is below 30 volume % by oxide conversion as mentioned above.

The desirable content of the above-mentioned rare earth element is below 12.0 volume % by oxide conversion.

A more desirable content is below 7.0 volume % by oxide conversion.

In the above-mentioned rare earth element, as for the oxide conversion, a content is calculated using as a standard compound each oxide of Sc₂O₃, Y₂O₃, La₂O₃, CeO₂, Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, Lu₂O₃.

Since the above-mentioned rare earth elements carry out the action by which the trap of the oxygen contained in a raw material is carried out, it is made to deposit as a grain boundary phase, and high purification of the aluminum nitride crystal grain in a sintered compact is carried out, promoting densification of an aluminum nitride powder compact, they raise the thermal conductivity of the substrate obtained on the whole.

Therefore, the existence form of a rare earth element in the sintered compact which comprises an aluminum nitride as the main ingredients and is used as a substrate for light emitting device mounting is a rare earth element oxide or a complex oxide with aluminum in many cases.

The existence as a complex oxide with aluminum can be easily identified by X ray diffraction.

This complex oxide has three kinds of crystal forms, such as 3Ln₂O₃.5Al₂O₃ of a garnet type crystal structure, Ln₂O₃.Al₂O₃ of a perovskite type crystal structure, and monoclinic system crystal structure 2Ln₂O₃.Al₂O₃, when a rare earth element is expressed with Ln.

Among these complex oxides, one or two or more are included simultaneously.

The above-mentioned complex oxide mainly exists as a grain boundary phase between aluminum nitride particles in the inside of a sintered compact.

The substrate for light emitting device mounting according to this invention which used the sintered compact which comprises an aluminum nitride as the main ingredients contains that in which these complex oxide was formed.

These complex oxides have a different crystal structure from the wurtzite type of an aluminum nitride particle.

In the substrate for light emitting device mounting according to this invention, what is the optical transmissivity not less than 1% is easy to be obtained in the case of the sintered compact which comprises an aluminum nitride as the main ingredients and whose content of a rare earth element compound is below 30 volume % by oxide conversion.

If the rare earth element compound in this sintered compact which comprises an aluminum nitride as the main ingredients is more than 30 volume % by oxide conversion as shown above, the sintered compact which comprises an aluminum nitride as the main ingredients and which has optical permeability will become hard to be obtained.

As the reason, this inventor is guessing that since the crystal of a complex oxide of the rare earth element and aluminum in a sintered compact differs from the wurtzite type crystal of AlN, when luminescence from a light emitting device is irradiated inside a sintered compact, light scattering increases between the particles of a complex oxide of the rare earth element and aluminum in the inside of a sintered compact and the particles which have a different crystal system of the aluminum nitride particle, light stops being able to penetrate a substrate easily as a result.

In this invention, in the substrate for light emitting device mounting, the form of a aluminum nitride particle in the sintered compact which comprises an aluminum nitride as the main ingredients and contains a rare earth element tends to become not a round thing whose edge was smoothed out but a dense thing which is a polygon and has not a space at the surface of particles, the ridgeline, or the polygonal vertex by accompanying a overlap.

In the above-mentioned substrate for light emitting device mounting according to this invention, what is the optical transmissivity not less than 5% is easy to be obtained in the sintered compact which comprises an aluminum nitride as the main ingredients and whose content of a rare earth element is below 12.0 volume % by oxide conversion.

And, in the above-mentioned substrate for light emitting device mounting according to this invention, what is the optical transmissivity not less than 10% is easy to be obtained in the sintered compact which comprises an aluminum nitride as the main ingredients and whose content of a rare earth element is below 7.0 volume % by oxide conversion.

As for this improvement of the optical permeability accompanying the reduction of the rare earth element content in the sintered compact which comprises an aluminum nitride as the main ingredients, it is surmised that it will be because it is a thing accompanying reduction of the amount of generation of the above-mentioned 3Ln₂O₃.5Al₂O₃ of a garnet type crystal structure (for example, 3Y₂O₃.5Al₂O₃, 3Dy₂O₃.5Al₂O₃, 3Ho₂O₃.5Al₂O₃, 3Er₂O₃.5Al₂O₃, 3Yb₂O₃.5Al₂O₃, etc.), Ln₂O₃.Al₂O₃ of a perovskite type crystal structure (for example, YAlO₃, LaAlO₃, PrAlO₃.NdAlO₃, SmAlO₃, EuAlO₃, GdAlO₃, DyAlO₃, HoAlO₃, ErAlO₃, YbAlO₃, etc.), and monoclinic system crystal structure 2Ln₂O₃.Al₂O₃ (for example, 2Y₂O₃.Al₂O₃, 2Eu₂O₃.Al₂O₃, 2Gd₂O₃.Al₂O₃, 2Dy₂O₃.Al₂O₃, 2Ho₂O₃.Al₂O₃, 2Er₂O₃.Al₂O₃, 2Yb₂O₃.Al₂O₃, etc.) which probably exists mainly as a grain boundary phase.

In the sintered compact which comprises an aluminum nitride as the main ingredients and contains a rare earth element of the above range and which is used as a substrate for light emitting device mounting according to this invention, what has the optical transmissivity still higher than what was shown above is obtained, what has the optical transmissivity of a maximum of not less than 80%-85% is obtained.

In the sintered compact which comprises an aluminum nitride as the main ingredients and is used as a substrate for light emitting device mounting of this invention, it is preferred that the content of the above-mentioned alkaline-earth metal is also below 30 volume % by oxide conversion as above-mentioned.

A desirable content is below 5.0 volume % by oxide conversion.

A more desirable content is below 3.0 volume % by oxide conversion.

In the above-mentioned alkaline-earth metals, a content is calculated by oxide conversion using each oxide of BeO, MgO, CaO, SrO, and BaO as a standard compound.

Since the alkaline-earth metal carry out the action by which the trap of the oxygen contained in a raw material is carried out, it is made to deposit as a grain boundary phase, and high purification of the aluminum nitride crystal grain in a sintered compact is carried out, promoting densification of an aluminum nitride powder compact, they raise the thermal conductivity of the substrate obtained on the whole.

Therefore, the existence form of a alkaline-earth metal element in the sintered compact which comprises an aluminum nitride as the main ingredients and is used as a substrate for light emitting device mounting is a complex oxide with aluminum in many cases.

The existence as a complex oxide with aluminum can be easily identified by X ray diffraction.

This complex oxide is what is the crystal forms, such as 3AeO.Al₂O₃, Ae.Al₂O₃, Ae.2Al₂O₃, and Ae.6Al₂O₃, when an alkaline-earth metal is expressed with Ae.

Among these complex oxides, one or two or more are included simultaneously.

The above-mentioned complex oxide containing an alkaline-earth metal mainly exists as a grain boundary phase between aluminum nitride particles in the inside of a sintered compact.

The substrate for light emitting device mounting according to this invention contains the thing in which these complex oxides were formed.

These complex oxides have a different crystal structure from the wurtzite type of an aluminum nitride particle.

In the substrate for light emitting device mounting of this invention, what is the optical transmissivity not less than 1% is easy to be obtained in the sintered compact which comprises an aluminum nitride as the main ingredients and whose content of an alkaline-earth metal is not more than 30 volume % by oxide conversion.

In the substrate for light emitting device mounting of this invention, if the alkaline-earth metal is more than 30 volume % by oxide conversion as shown above, the sintered compact which comprises an aluminum nitride as the main ingredients and which is excellent in optical permeability will become hard to be obtained.

As the reason, this inventor is guessing that since the crystal of a complex oxide of an alkaline-earth metal and an aluminum in a sintered compact differs from the wurtzite type crystal of AlN, when luminescence from a light emitting device is irradiated inside a sintered compact, light scattering increases between the particles of a complex oxide of an alkaline-earth metal and an aluminum in the inside of a sintered compact and the particles which have a different crystal system of the aluminum nitride particle, light stops being able to penetrate a substrate easily as a result.

In the substrate for light emitting device mounting according to this invention, as for that whose content of an alkaline earth metal is not more than 5.0 volume % by oxide conversion in the sintered compact which comprises an aluminum nitride as the main ingredients, there are many whose form of the aluminum nitride particle in a sintered compact is a polygon, it is easy to become into that whose overlap in each surface and ridgeline, or at a polygonal vertex is tight.

In the substrate for light emitting device mounting according to this invention, what is the optical transmissivity not less than 5% is easy to be obtained in the sintered compact which comprises an aluminum nitride as the main ingredients and contains an alkaline-earth metal of the composition range of not more than 5.0 volume % by oxide conversion.

And, in the substrate for light emitting device mounting according to this invention, what is the optical transmissivity not less than 10% is easy to be obtained in the sintered compact which comprises an aluminum nitride as the main ingredients and whose content of an alkaline-earth metal is not more than 3.0 volume % by oxide conversion.

As for this improvement of the optical permeability accompanying the reduction of the amount of an alkaline-earth metal compound in the sintered compact which comprises an aluminum nitride as the main ingredients, it is surmised that it will be because it is a thing accompanying reduction of the amount of generation of the above-mentioned 3AeO.Al₂O₃, Ae.Al₂O₃, Ae.2Al₂O₃, and Ae.6Al₂O₃, etc., which probably exists mainly as a grain boundary phase.

In the sintered compact which comprises an aluminum nitride as the main ingredients and contains alkaline-earth-metals compound of the above range and which uses as a substrate for light emitting device mounting according to this invention, what has the optical transmissivity still higher than what was shown above is obtained, what has the optical transmissivity of a maximum of not less than 80%-85% is also obtained.

In the substrate for light emitting device mounting according to this invention, in order to aim at reduction of firing temperature, what has alkaline metals, such as Li, Na, and K, etc., or alkali metal compounds, such as Li₂O, Li₂CO₃, LiF, LiOH, Na₂O, Na₂CO₃, NaF, NaOH, K₂O, K₂CO₃, KF, and KOH, etc., or Si, or the compound containing silicon, such as SiO₂, Si₃N₄, and SiC, etc., can be used as the sintered compact which comprises an aluminum nitride as the main ingredients.

Even if it is the sintered compact which comprises an aluminum nitride as the main ingredients and contains alkaline metal or silicon which promotes reduction of such firing temperature, if the content is below 5 volume % by oxide conversion, the sintered compact which comprises an aluminum nitride as the main ingredients and which has optical permeability will be obtained.

In the above-mentioned alkaline metal and an alkali metal compound, to oxide conversion a content is calculated by using each oxide of Li₂O, Na₂O, K₂O, Rb₂O, and Cs₂O as a standard compound.

In the compound containing silicon and silicon, to oxide conversion a content is calculated by SiO₂ (density: 2.65 g/cm³) as a standard compound.

That is, in the substrate for light emitting device mounting according to this invention, if it is the sintered compact which comprise an aluminum nitride as the main ingredients and whose content of at least one or more materials selected from an alkaline metal or silicon is below 5 volume % by oxide conversion, what is the optical transmissivity not less than 1% is obtained.

In the substrate for light emitting device mounting according to this invention, what is the optical transmissivity not less than 5% is obtained in the sintered compact which comprises an aluminum nitride as the main ingredients and whose content of at least one or more materials selected from an alkaline metal or silicon is not more than 3 volume % by oxide conversion.

In the substrate for light emitting device mounting according to this invention, what is the optical transmissivity not less than 10% is obtained in the sintered compact which comprises an aluminum nitride as the main ingredients and whose content of at least one or more materials selected from an alkaline metal or silicon is not more than 1 volume % by oxide conversion.

In the sintered compact which comprises an aluminum nitride as the main ingredients and has at least one or more materials selected from an alkaline metal or silicon in the above range and which uses as a substrate for light emitting device mounting according to this invention, what has the optical transmissivity still higher than what was shown above is obtained, what has the optical transmissivity of a maximum of not less than 80%-85% is obtained.

In the substrate for light emitting device mounting according to this invention, in order to achieve coloring-ization to black, ashes black, and gray, etc., what contains ingredients, such as the metal, alloy and metallic compound containing Mo, W, V, Nb, Ta, Ti, etc., and carbon, can also be used as a sintered compact which comprises an aluminum nitride as the main ingredients.

If using the sintered compact which comprises an aluminum nitride as the main ingredients and presents such black etc., since luminescence emitted to the substrate exterior from the substrate for light emitting device mounting according to this invention will tend to become gentler, coloring-izing of the sintered compact which comprises an aluminum nitride as the main ingredients to black, ashes black, and gray, etc. is effective when using it as a substrate for light emitting device mounting.

Even if the ingredient which is easy to promote coloring-ization of this sintered compact which comprises an aluminum nitride as the main ingredients and is illustrated above is contained in the sintered compact which comprises an aluminum nitride as the main ingredients, if the content is below 5 volume % by element conversion, what has optical permeability will be obtained.

That is, in the substrate for light emitting device mounting according to this invention, what is the optical transmissivity not less than 1% is easy to be obtained in the sintered compact which comprises an aluminum nitride as the main ingredients and whose content of at least one or more ingredients selected from Mo, W, V, Nb, Ta, Ti, and carbon is below 5 volume % by element conversion.

And, in the substrate for light emitting device mounting according to this invention, what is the optical transmissivity not less than 5% is easy to be obtained in the sintered compact which comprises an aluminum nitride as the main ingredients and whose content of at least one or more ingredients selected from Mo, W, V, Nb, Ta, Ti, and carbon is below 3 volume % by element conversion.

And, in the substrate for light emitting device mounting according to this invention, what is the optical transmissivity not less than 10% is easy to be obtained in the sintered compact which comprises an aluminum nitride as the main ingredients and whose content of at least one or more ingredients selected from Mo, W, V, Nb, Ta, Ti, and carbon is below 1 volume % by element conversion.

In the sintered compact which comprises an aluminum nitride as the main ingredients and contains at least one or more ingredients selected from Mo, W, V, Nb, Ta, Ti, and carbon in the above range and which uses as a substrate for light emitting device mounting according to this invention, what has the optical transmissivity still higher than what was shown above is obtained, what has the optical transmissivity of a maximum of not less than 80%-85% is also obtained. In the substrate for light emitting device mounting according to this invention, it seems that the oxygen contained in the sintered compact which comprises an aluminum nitride as the main ingredients exists in either, it reacts with AlN of the main ingredient and exists as ALON, or it reacts with the rare-earth compound and alkaline-earth-metals compound of sintering aids, and exists as a grain boundary phase, or dissolves to the crystalline lattice of the AlN crystal grain in a sintered compact.

In the substrate for light emitting device mounting according to this invention, it is preferred that the total amount of oxygen contained in the sintered compact which comprises an aluminum nitride as the main ingredients is not more than 10 weight %.

In the substrate for light emitting device mounting according to this invention, what is the optical transmissivity not less than 1% is easy to be obtained in the sintered compact which comprises an aluminum nitride as the main ingredients and in which the total amount of oxygen is not more than 10 weight %.

In the substrate for light emitting device mounting according to this invention, what is the optical transmissivity not less than 5% is easy to be obtained in the sintered compact which comprises an aluminum nitride as the main ingredients and in which the total amount of oxygen is not more than 5.0 weight %.

In the substrate for light emitting device mounting according to this invention, what is the optical transmissivity not less than 10% is easy to be obtained in the sintered compact which comprises an aluminum nitride as the main ingredients and in which the total amount of oxygen is not more than 3.0 weight %.

In this invention, when the sintered compact which comprises an aluminum nitride as the main ingredients contains a rare earth element and an alkaline-earth metal, or when it contains an alkaline metal and silicon, or when it contains Mo, W, V, Nb, Ta, Ti, and carbon, etc., or when it contains unescapable metal ingredients, such as iron, nickel, chromium, manganese, zirconium, hafnium, cobalt, copper, and zinc, even if only the oxygen of a quantity smaller than the above range is included, optical transmissivity may lower.

Conversely, even if the oxygen of more quantity than the above range is included, what has comparatively high optical transmissivity may be obtained without lowering the optical transmissivity.

That is, in this invention, when the sintered compact which comprises an aluminum nitride as the main ingredients contains a rare earth element compound and an alkaline-earth-metals compound, or when it contains an alkali metal compound and a silicon content compound, or when it contains Mo, W, V, Nb, Ta, Ti, and carbon, etc., or when it contains unescapable metal ingredients, such as iron, nickel, chromium, manganese, zirconium, hafnium, cobalt, copper, and zinc, even if the amount of oxygen contained is not more than 10 weight %, what is the optical transmissivity not less than 1% may arise, even if the amount of oxygen contained is not more than 5.0 weight %, what is the optical transmissivity not less than 5% may arise, further, even if the amount of oxygen contained is not more than 3.0 weight %, what is the optical transmissivity not less than 10% may arise.

It is guessed probably that if ingredients other than the above-mentioned aluminum nitride are contained, a complicated compound will generate during firing, it deposits as a grain boundary phase of a sintered compact, and optical transmissivity becomes easy to be prevented.

And, in this invention, when the sintered compact which comprises an aluminum nitride as the main ingredients contains a rare earth element compound and an alkaline-earth-metals compound, or when it contains an alkali metal compound and a silicon content compound, or when it contains Mo, W, V, Nb, Ta, Ti, and carbon, etc., or when it contains unescapable metal ingredients, such as iron, nickel, chromium, manganese, zirconium, hafnium, cobalt, copper, and zinc, even if the amount of oxygen contained is not less than 10 weight %, what is the optical transmissivity not less than 1% may arise, even if the amount of oxygen contained is not less than 5.0 weight %, what is the optical transmissivity not less than 5% may arise, further, even if the amount of oxygen contained is not less than 3.0 weight %, what is the optical transmissivity not less than 10% may arise.

It is guessed probably that ingredients other than the above-mentioned aluminum nitride take in oxygen from an aluminum nitride particle etc. effectively, for example, it is made to deposit as a grain boundary phase, and lowering of the optical transmissivity by oxygen is prevented. In the sintered compact which comprises an aluminum nitride as the main ingredients and contains the oxygen of the above range and which uses as a substrate for light emitting device mounting according to this invention, what has the optical transmissivity still higher than what was shown above is obtained, what has the optical transmissivity of a maximum of not less than 80%-85% is obtained.

As mentioned above, even if it is the sintered compact which comprises an aluminum nitride as the main ingredients and contains comparatively many oxygen, or ingredients used as sintering aid, such as a rare-earth compound and an alkaline earth metal compound, or the ingredients used as a firing temperature reduction-ized agent, such as an alkali metal and silicon, or the metal ingredients and carbon which are used as a black-ized agent, such as Mo, W, V, Nb, Ta, and Ti, or unescapable metal ingredients other than Mo, W, V, Nb, Ta, and Ti etc. or ALON etc., as optical transmissivity what is not less than 80%-85% which is still higher than the optical transmissivity shown above is obtained.

The high thing whose optical transmissivity is 87% experimentally was actually obtained. Thus, in this invention, since what has high optical transmissivity is obtained even if it is the sintered compact which comprises an aluminum nitride as the main ingredients and whose AlN purity is not necessarily high, even if it is the sintered compact which comprises an aluminum nitride as the main ingredients and whose AlN purity is not high, it can use as a substrate for light emitting device mounting.

In this invention, the sintered compact which comprises an aluminum nitride as the main ingredients and contained simultaneously at least one or more ingredients selected from the above-mentioned ingredients, such as alkaline metal and silicon etc., or ingredients, such as Mo, W, V, Nb, Ta, Ti, and carbon etc., or unescapable metal ingredients, such as iron, nickel, chromium, manganese, a zirconium, hafnium, cobalt, copper, and zinc etc., or oxygen and at least one or more ingredients selected from a rare earth element and an alkaline earth metal which are used as sintering aids can also be used as a substrate for light emitting device mounting.

As mentioned above, as for the sintered compact which comprises an aluminum nitride as the main ingredients and contained simultaneously at least one or more ingredients selected from the above-mentioned ingredients, such as alkaline metal and silicon etc., or ingredients, such as Mo, W, V, Nb, Ta, Ti, and carbon etc., or unescapable metal ingredients, such as iron, nickel, chromium, manganese, a zirconium, hafnium, cobalt, copper, and zinc etc., or oxygen and at least one or more ingredients selected from a rare earth element and an alkaline earth metal, since the firing temperature at the time of sintered compact manufacture can be lowered compared with the case where a rare earth element and an alkaline-earth metal are not included, manufacture may become easy, and since it may become possible to raise the optical transmissivity of the manufactured sintered compact which comprises an aluminum nitride as the main ingredients, it is desirable.

This inventor further investigated improvement about the optical permeability of the sintered compact which comprises an aluminum nitride as the main ingredients and has high AlN purity and whose content of ALON as a crystal phase, the above-mentioned metal ingredients other than aluminum, and the compound containing silicon or carbon was reduced by making the contained oxygen or ingredients which are used as sintering aids such as a rare-earth compound and an alkaline earth metal compound or ingredients which are used as a firing temperature reduction-ized agents such as an alkali metal and silicon or metal ingredients which are used as black-ized agents such as Mo, W, V, Nb, Ta, Ti or carbon or unescapable metal ingredients other than Mo, W, V, Nb, Ta, Ti, etc. vaporize, remove, and decrease by performing firing at the temperature not less than 1750 degrees C. for not less than 3 hours in reduced atmosphere, and tried the improvement of the characteristic as a substrate for mounting the light emitting device which comprises as the main ingredients at least one or more materials selected from a gallium nitride, an indium nitride, and an aluminum nitride using this sintered compact.

In the above-mentioned sintered compact which comprises an aluminum nitride as the main ingredients, AlN purity tends to become high as firing temperature becomes high, and as it lengthens firing time.

As firing temperature, not less than 1900 degrees C. are more preferred, not less than 2050 degrees C. are still more preferred, and not less than 2100 degrees C. are the most preferred. When raising the AlN purity of the sintered compact which comprises an aluminum nitride as the main ingredients, it has a relation that firing time can be shortened if firing temperature is raised, and firing time will become long if firing temperature is made low, an effect is almost the same in either.

In order to raise the purity of AlN, as for firing time, in the range of a firing temperature of 1750 degrees C.-1900 degrees C., it is preferred to usually make it not less than 10 hours.

It is preferred to have firing time not less than 6 hours in firing temperature not less than 1900 degrees C., firing time not less than 4 hours in firing temperature not less than 2050 degrees C., and firing time not less than 3 hours in firing temperature not less than 2100 degrees C.

By such a method, as the sintered compact according to this invention which comprises an aluminum nitride as the main ingredients and raised the AlN purity, what has the composition of that whose content of at least one or more materials selected from a rare earth element and an alkaline-earth metal is a total of not more than 0.5 weight % (5000 ppm) by element conversion and whose oxygen content is not more than 0.9 weight % can be obtained. Therefore, optical transmissivity tends to improve in the sintered compact which comprises an aluminum nitride as the main ingredients and raised the AlN purity of such composition.

Therefore, the sintered compact which comprises an aluminum nitride as the main ingredients and raised the AlN purity of such composition can become the excellent thing as a substrate for mounting the light emitting device that comprises as the main ingredients at least one or more materials selected from a gallium nitride, an indium nitride, and an aluminum nitride.

In the substrate for light emitting device mounting according to this invention, as the sintered compact which comprises an aluminum nitride as the main ingredients and raised AlN purity, what has the composition of that whose content of at least one or more materials selected from a rare earth element and an alkaline-earth metal is a total of not more than 0.2 weight % (2000 ppm) by element conversion and whose oxygen content is not more than 0.5 weight % can be obtained, it is desirable.

In the substrate for light emitting device mounting according to this invention, as the sintered compact which comprises an aluminum nitride as the main ingredients and raised AlN purity, what has the composition of that whose content of at least one or more materials selected from a rare earth element and an alkaline-earth metal is a total of not more than 0.05 weight % (500 ppm) by element conversion and whose oxygen content is not more than 0.2 weight % can be obtained, it is more desirable.

In the substrate for light emitting device mounting according to this invention, as the sintered compact which comprises an aluminum nitride as the main ingredients and raised AlN purity, what has the composition of that whose content of at least one or more materials selected from a rare earth element and an alkaline-earth metal is a total of not more than 0.02 weight % (200 ppm) by element conversion and whose oxygen content is not more than 0.1 weight % can be obtained, it is still more desirable.

In the substrate for light emitting device mounting according to this invention, as the sintered compact which comprises an aluminum nitride as the main ingredients and raised AlN purity, what has the composition of that whose content of at least one or more materials selected from a rare earth element and an alkaline-earth metal is a total of not more than 0.005 weight % (50 ppm) by element conversion and whose oxygen content is not more than 0.05 weight % can be obtained, it is the most desirable.

This inventor confirmed that even if it is the case where the above-mentioned sintered compact which comprises an aluminum nitride as the main ingredients and raised the AlN purity is used for substrate for light emitting device mounting, when luminescence from the light emitting device which comprises as the main ingredients at least one or more materials selected from a gallium nitride, an indium nitride, and an aluminum nitride and is mounted on this substrate penetrates this substrate and is emitted to the substrate exterior, although this emitted light is a strong light, unlike going-straight light which penetrated transparent glass, resin, etc. and pierces the eye, it was easy to become a gentle scattered light.

In the substrate for light emitting device mounting according to this invention, as the sintered compact which comprises an aluminum nitride as the main ingredients and raised AlN purity, what has the composition of that whose content of at least one or more materials selected from a rare earth element and an alkaline-earth metal is a total of not more than 0.5 weight % by element conversion and whose oxygen content is not more than 0.9 weight % is easy to obtain what is the optical transmissivity not less than 1%.

In the substrate for light emitting device mounting according to this invention, as the sintered compact which comprises an aluminum nitride as the main ingredients and raised AlN purity, what has the composition of that whose content of at least one or more materials selected from a rare earth element and an alkaline-earth metal is a total of not more than 0.2 weight % by element conversion and whose oxygen content is not more than 0.5 weight % is easy to obtain what is It is easy to obtain what is the optical transmissivity not less than 20%, it is desirable.

In the substrate for light emitting device mounting according to this invention, as the sintered compact which comprises an aluminum nitride as the main ingredients and raised AlN purity, what has the composition of that whose content of at least one or more materials selected from a rare earth element and an alkaline-earth metal is a total of not more than 0.05 weight % by element conversion and whose oxygen content is not more than 0.2 weight % is easy to obtain what is the optical transmissivity not less than 30%, it is more desirable.

In the substrate for light emitting device mounting according to this invention, as the sintered compact which comprises an aluminum nitride as the main ingredients and raised AlN purity, what has the composition of that whose content of at least one or more materials selected from a rare earth element and an alkaline-earth metal is a total of not more than 0.02 weight % by element conversion and whose oxygen content is not more than 0.1 weight % is easy to obtain what is the optical transmissivity not less than 40%, it is still more desirable.

In the substrate for light emitting device mounting according to this invention, as the sintered compact which comprises an aluminum nitride as the main ingredients and raised AlN purity, what has the composition of that whose content of at least one or more materials selected from a rare earth element and an alkaline-earth metal is a total of not more than 0.005 weight % by element conversion and whose oxygen content is not more than 0.05 weight % is easy to obtain what is the optical transmissivity not less than 50%, it is the most desirable.

In the sintered compact which comprises an aluminum nitride as the main ingredients and raised such AlN purity, in spite of being a polycrystalline substance, what is the thing which is still higher than the above one and whose optical transmissivity is not less than 80%-85% is also obtained.

The high thing whose optical transmissivity is 88% experimentally was actually obtained. The crystal phase contained in the sintered compact which comprises an aluminum nitride as the main ingredients and has the above-mentioned composition which raised the AlN purity is not less than 95-98% of AlN, crystal phases, such as ALON and a rare earth element compound or an alkaline-earth-metals compound, are not more than 2-5%, what is substantially an AlN single phase is also obtained.

The crystal phase in the sintered compact which comprises an aluminum nitride as the main ingredients can be identified easily by carrying out the relative comparison of the strongest line of a diffraction peak where each crystal phase obtained by X ray diffraction indicates.

By the above-mentioned method, in addition to oxygen or a rare earth element or an alkaline-earth metal, since ingredients which are used as a calcination temperature reduction-ized agent, such as an alkaline metal and silicon etc., or ingredients which are used as a black-ized agent, such as Mo, W, V (vanadium), Nb, Ta, Ti, and carbon, etc., or transition metal impurities which are mixed from aluminum nitride powder raw materials and sintered compact manufacturing processes other than Mo, W, V, Nb, Ta, and Ti, such as Fe, Ni, Co, Mn, Cr, Zr, Cu, Zn, etc., can be vaporized, removed, and lowered, an aluminum nitride sintered compact with high AlN purity can be manufactured.

As the sintered compact which comprises an aluminum nitride as the main ingredients and raised AlN purity, in what has the composition of that whose contained alkaline metal and silicon ingredients are a total of not more than 0.2 weight % by element conversion and whose amount of oxygen is not more than 0.9 weight %, what is the optical transmissivity not less than 30% is easy to be obtained.

In the sintered compact which comprises an aluminum nitride as the main ingredients and has the alkaline metal and silicon ingredients in the above range and which uses as a substrate for light emitting device mounting according to this invention, what has the optical transmissivity still higher than what was shown above is obtained, what has the optical transmissivity of a maximum of not less than 80%-85% is obtained.

As the sintered compact which comprises an aluminum nitride as the main ingredients and raised AlN purity, in what has the composition of that whose Mo, W, V (vanadium), Nb, Ta, Ti, and carbon are a total of not more than 0.2 weight % by element conversion and whose amount of oxygen is not more than 0.9 weight %, what is the optical transmissivity not less than 30% is easy to be obtained.

In the sintered compact which comprises an aluminum nitride as the main ingredients and has Mo, W, V (vanadium), Nb, Ta, Ti, and carbon in the above range and which uses as a substrate for light emitting device mounting according to this invention, what has the optical transmissivity still higher than what was shown above is obtained, what has the optical transmissivity of a maximum of not less than 80% -85% is obtained.

As the sintered compact which comprises an aluminum nitride as the main ingredients and raised AlN purity, in what has the composition of that whose Fe, Ni, Co, Mn, Cr, Zr, Cu, Zn are a total of not more than 0.2 weight % by element conversion and whose amount of oxygen is not more than 0.9 weight %, what is the optical transmissivity not less than 30% is easy to be obtained.

In the sintered compact which comprises an aluminum nitride as the main ingredients and has Fe, Ni, Co, Mn, Cr, Zr, Cu, and Zn in the above range and which uses as a substrate for light emitting device mounting according to this invention, what has the optical transmissivity still higher than what was shown above is obtained, what has the optical transmissivity of a maximum of not less than 80%-85% is obtained.

The rare earth element compound contained in the above-mentioned sintered compact which comprises an aluminum nitride as the main ingredients is a rare earth element, such as Sc, Y, La, Ce, Pr, Nd, Pm, Sm, Eu, Gd, Tb, Dy, Ho, Er, Tm, Yb, and Lu, and a rare earth element oxide, such as Sc₂O₃, Y₂O₃, La₂O₃, CeO₂ and Pr₆O₁₁, Nd₂O₃, Pm₂O₃, Sm₂O₃, Eu₂O₃, Gd₂O₃, Tb₄O₇, Dy₂O₃, Ho₂O₃, Er₂O₃, Tm₂O₃, Yb₂O₃, and Lu₂O₃, or, in addition, various rare earth element compounds, such as inorganic rare earth compounds, such as carbonate, nitrate, sulfate, and chloride, organic rare earth compounds, such as acetate, oxalate, and citrate etc., containing Sc, Y, La, Ce, Pr, Nd, Pm, Sm, Eu, Gd, Tb, Dy, Ho, Er, Tm, Yb, Lu, etc., further the complex oxide containing various rare earth elements, such as 3Ln₂O₃.5Al₂O₃ of a garnet type crystal structure (for example, 3Y₂O₃.5Al₂O₃, 3Dy₂O₃.5Al₂O₃, 3Ho₂O₃.5Al₂O₃, 3Er₂O₃.5Al₂O₃, 3Yb₂O₃.5Al₂O₃, etc.), Ln₂O₃.Al₂O₃ of a perovskite type crystal structure (for example, YAlO₃, LaAlO₃, PrAlO₃, NdAlO₃, SmAlO₃, EuAlO₃, GdAlO₃, DyAlO₃, HoAlO₃, ErAlO₃, YbAlO₃, etc.), and monoclinic system crystal structure 2Ln₂O₃.Al₂O₃ (for example, 2Y₂O₃.Al₂O₃, 2Sm₂O₃, 2Eu₂O₃.Al₂O₃, 2Gd₂O₃.Al₂O₃, 2Dy₂O₃.Al₂O₃, 2Ho₂O₃.Al₂O₃, 2Er₂O₃.Al₂O₃, 2Yb₂O₃.Al₂O₃) etc., when a rare earth element is expressed with Ln.

The alkaline earth metal compound contained in the above-mentioned aluminum nitride sintered compact is alkaline earth metals, such as Be, Mg, Ca, Sr, and Ba, etc., and alkaline earth metal oxide, such as BeO, MgO, CaO, SrO, and BaO, etc., or, in addition, various alkaline earth metal compounds, such as inorganic alkaline earth metal compounds, such as carbonate, nitrate, sulfate, and chloride, organic alkaline earth metal compounds, such as acetate, oxalate, and citrate, containing Be, Mg, Ca, Sr, and Ba, etc., and further the complex oxides which include an alkaline earth metal, such as 3AeO.Al₂O₃, Ae.Al₂O₃, Ae.2Al₂O₃, and Ae.6Al₂O₃, etc., when an alkaline earth metal element is expressed with Ae.

The feature of the sintered compact which comprises an aluminum nitride as the main ingredients obtained by the method of heating at the temperature not less than 1750 degrees C. for a comparatively long time not less than 3 hours in the above-mentioned reduced atmosphere is that what has the high thermal conductivity not less than 200 W/mK in room temperature is easy to be obtained.

In the sintered compact which comprises an aluminum nitride as the main ingredients, in the case of what has a few impurities content and what consists of an AlN single phase, what is the thermal conductivity not less than 220 W/mK in room temperature is easy to be obtained further.

In addition to such a feature, as for the above-mentioned sintered compact which comprises an aluminum nitride as the main ingredients and raised AlN purity, what has high optical permeability is easy to be obtained.

In addition to a rare earth element or an alkaline-earth metal, it is surmised that it will be because ingredients used as a firing temperature reduction-ized agent, such as an alkaline metal and silicon or ingredients, such as Mo, W, V (vanadium), Nb, Ta, Ti, carbon, etc. which are used as a black-ized agent or transition metal impurities, such as Fe, Ni, Co, Mn, etc. which are mixed from aluminum nitride powder raw materials and sintered compact manufacturing processes other than Mo, W, V, Nb, Ta, and Ti are vaporized, removed, and lowered.

Even if it is the sintered compact whose impurities and sintering aids, such as the above-mentioned transition metal, remain, what has thermal conductivity not less than 200 W/mK in room temperature, further what has high thermal conductivity not less than 220 W/mK, or the sintered compact which comprises an aluminum nitride as the main ingredients and is more excellent in optical permeability are obtained.

This inventor is probably surmising that this will be to become easier to generate the property of a single crystal of which AlN originally has since the aluminum nitride particle in a sintered compact grows greatly by heating for a long time and the effect of a grain boundary decreases.

According to this invention, the size of an aluminum nitride particle in the sintered compact which comprises an aluminum nitride as the main ingredients usually increases in the above-mentioned firing process which performs purity-ization.

It seems that that whose size of an aluminum nitride particle in the above-mentioned sintered compact which comprises an aluminum nitride as the main ingredients and which was purified and raised AlN purity increases is the big factor which gives still higher optical transmissivity.

By raising firing temperature or lengthening firing time, it vaporizes, removes and decreases, ingredients other than AlN, such as sintering aids in the sintered compact which comprises an aluminum nitride as the main ingredients, and ingredients other than AlN decrease in the inside of an aluminum nitride particle or in the grain boundary of an aluminum nitride particle in a sintered compact, or it becomes close to zero substantially, in addition to it, the size of the aluminum nitride crystal grain in a sintered compact increases.

It is surmised that in the sintered compact which comprises an aluminum nitride as the main ingredients, ingredients other than AlN decrease in the inside of an aluminum nitride particle, or in the grain boundary of an aluminum nitride particle, or it becomes close to zero substantially, in addition to it, since aluminum nitride particle boundaries (grain boundary) will decrease in number if the size of the aluminum nitride particle in a sintered compact increases, the effect of a grain boundary decreases, high purification of this aluminum nitride particle itself that increased greatly is carried out, crystallinity also increases further and it becomes easy to generate the property near the aluminum nitride of a single crystal with high purity.

That is, since it is the sintered compact which consists of a big crystal grain of the condition near a single crystal with high purity, an optical permeability also comes to have the high optical transmissivity which matches a single crystal in the long wavelength side from near the wavelength 200 nm of the absorption end of an aluminum nitride single crystal.

This inventor has confirmed that luminescence from the light emitting device which comprises as the main ingredients at least one or more materials selected from a gallium nitride, an indium nitride, and an aluminum nitride and is being mounted can penetrate a substrate and be emitted to the substrate exterior efficiently if this sintered compact is used as a substrate for light emitting device mounting, although this emitted light is a strong light, unlike going-straight light which penetrated transparent glass, resin, etc. and pierces the eye, it was easy to become a gentle scattered light.

In this invention, although the sintered compact which comprises an aluminum nitride as the main ingredients and raised AlN purity is manufactured by raising firing temperature or by lengthening firing time, the size of the aluminum nitride particle of this sintered compact is usually an average of not less than 5 μm.

Usually, if firing temperature is raised or firing time is lengthened, the size of the aluminum nitride particle in a sintered compact will also increase to an average of not less than 25 μm.

On the experiment, what has the size of about an average of 100 μm of an aluminum nitride particle is obtained.

Thus, it seems that the aluminum nitride particle which increased will be in the condition near a single crystal since AlN purity also increases.

In the substrate for light emitting device mounting according to this invention, what is the optical transmissivity not less than 10% is easy to obtain if the size of an aluminum nitride particle in the sintered compact which comprises an aluminum nitride as the main ingredients and which was formed into high purity by the above-mentioned method and raised AlN purity is an average of not less than 5 μm.

In the substrate for light emitting device mounting according to this invention, what is the optical transmissivity not less than 20% is easy to obtain if the size of an aluminum nitride particle in the sintered compact which comprises an aluminum nitride as the main ingredients and which was formed into high purity by the above-mentioned method and raised AlN purity is an average of not less than 8 μm.

And, in the substrate for light emitting device mounting according to this invention, what is the optical transmissivity not less than 30% is easy to obtain if the size of an aluminum nitride particle in the sintered compact which comprises an aluminum nitride as the main ingredients and which was formed into high purity by the above-mentioned method and raised AlN purity is an average of not less than 15 μm.

And, in the substrate for light emitting device mounting according to this invention, what is the optical transmissivity not less than 40% is easy to obtain if the size of an aluminum nitride particle in the sintered compact which comprises an aluminum nitride as the main ingredients and which was formed into high purity by the above-mentioned method and raised AlN purity is an average of not less than 25 μm.

Thus, the size of the aluminum nitride particle of the sintered compact which comprises an aluminum nitride as the main ingredients and which was made into high purity and is manufactured by vaporizing, removing and decreasing ingredients other than AlN, such as sintering aids, is important.

In this invention, as mentioned above, the sintered compact which comprises an aluminum nitride as the main ingredients and is an average of not less than 5 μm of the size of the aluminum nitride particle in a sintered compact can be provided, what is about an average of 100 μm can be manufactured comparatively easily as the size of the aluminum nitride particle in this sintered compact.

For example, the obtained sintered compact which comprises an aluminum nitride as the main ingredients by firing the powder compact which comprises as the raw material a high purity aluminum nitride powder of 1 μm mean particle diameter containing oxygen 1 weight % and which mixed Y₂O₃ of 3.3 volume % (includes 3.9 weight % as Y, and 1.1 weight % as oxygen) as sintering aid and is made into 60×60 mm of magnitude contours, and a board-like square with a thickness of 0.8 mm at 1800 degrees C. for 1 hour has the range of thermal conductivity 150 W/mK-180 W/mK in room temperature, the yttrium ingredient in Y₂O₃ used as sintering aid remains in a sintered compact almost as it is, it is admitted that about 5-20% of quantity of the grain boundary phase which comprises as the main substance a rare-earths compound, such as Y₂O₃.5Al₂O₃, YAlO₃, 2Y₂O₃.Al₂O₃, and Y₂O₃, etc., exists according to X-ray diffraction.

The quantity of the oxygen of a raw material and the oxygen in Y₂O₃ used as the sintering aid also remain in a sintered compact almost as it is, and the optical transmissivity of this sintered compact is about not more than 10%.

In the above-mentioned sintered compact, the size of an aluminum nitride particle is about an average of 2-4 μm.

If this sintered compact is further fired at 2050 degrees C.-2200 degrees C. for 3 hours-24 hours in the nitrogen ambient atmosphere which contains carbon monoxide in the range of 1 ppm-1000 ppm, for example, the oxygen contained in the used raw material and sintering aid decreased to not more than 0.5 weight %, and what has 0.014 weight % was obtained in the case of the fewest one.

Y₂O₃ were almost vaporized and removed, the content became not more than 0.2 weight %, the sintered compact which comprises an aluminum nitride as the main ingredients and has not more than 0.00005 weight % (0.5 ppm) was obtained in the case of the fewest one.

As for optical transmissivity to the light of the range of 200 nm-800 nm wavelength, at least not less than 10%, many are not less than 20%-60%, and what has a maximum of 88% were obtained.

The phase constitution of a sintered compact is more than 98% of AlN, and what has substantially an AlN single phase was also obtained easily.

The thermal conductivity became more than 200 W/mK-220 W/mK in room temperature, and what has a maximum of 239 W/mK was obtained.

The size of the aluminum nitride particle in this sintered compact was an average of not less than 5-8 μm of minimum, many were growing up greatly into an average of not less than 15 μm-25 μm, and what has a maximum of an average of 74 μm was obtained.

Using the sintered compact which comprises an aluminum nitride as the main ingredients and which is produced by the method of vaporizing, removing, and reducing the sintering aid on the firing conditions illustrated above and is made into high purity and whose AlN purity is raised, the optical transmissivity was measured by light of the range of 200 nm-800 nm wavelength, it was as high as 88% in the wavelength of 605 nm.

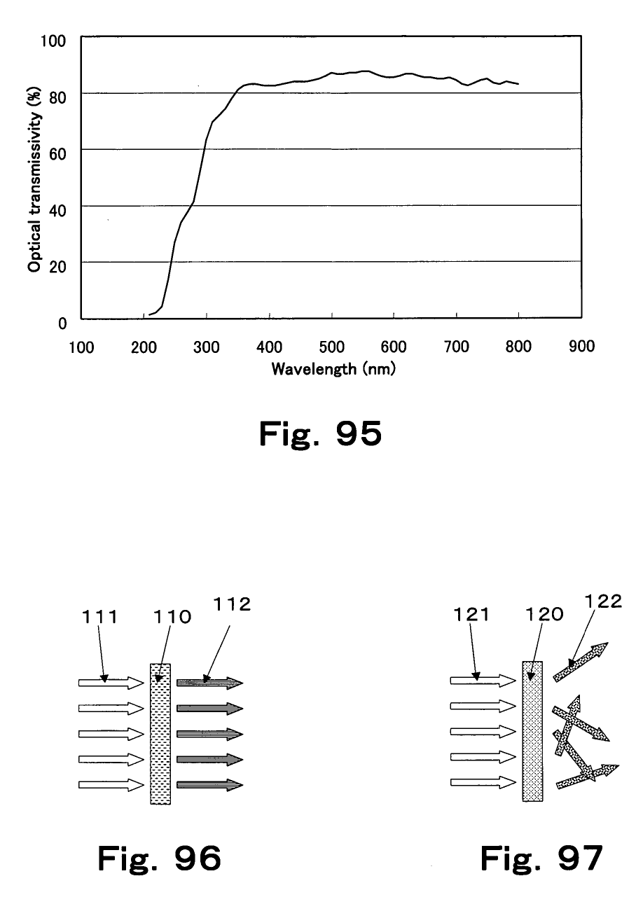

The result is shown in FIG. 95.

As for this sintered compact which comprises an aluminum nitride as the main ingredients used for this optical transmissivity measurement, Y (yttrium) content is not more than 0.0005 weight %, oxygen content is 0.034 weight %, the constitution phase is substantially an AlN single phase, and the size of an aluminum nitride particle is an average of 29 μm.

As it is clear from FIG. 95, as for the optical transmissivity of this sintered compact which comprises an aluminum nitride as the main ingredients, it should show permeability not less than 1% in the light of a wavelength 210-220 nm, transmissivity is not less than 5% in the light of a wavelength 220 nm-230 nm, transmissivity is not less than 30% in the light of a wavelength 250 nm, transmissivity is not less than 60% in the light of a wavelength 300 nm, and transmissivity not less than 80% comes to be shown in the light of a wavelength 330 nm, transmissivity not less than 80% is shown in the light of all wavelength of wavelength not less than 330 nm.

The maximum of optical transmissivity is 85-88% in the light of the range of 480 nm-650 nm wavelength, it is as high as not less than 85%.

The main validity when using the above-mentioned sintered compact which comprises an aluminum nitride as the main ingredients and raised AlN purity as a substrate for light emitting device mounting is summarized, that is, 1) since the optical transmissivity of a substrate is high in the range of 200 nm-800 nm wavelength, the optical absorption from a substrate is few, and luminescence from a light emitting device is efficiently emitted to the substrate exterior, 2) since luminescence from a light emitting device can be emitted to the substrate exterior efficiently, it is easy to control the emitting direction into the substrate exterior of this luminescence using a reflective prevention material or a reflective material, 3) since what has the thermal conductivity of a substrate as high as not less than 200 W/mK in room temperature is easy to be obtained, and applying of big electric power into the light emitting device mounted on such a substrate becomes possible, a luminescence output can be heightened, etc.

Namely, as for the manufacture of a substrate for light emitting device mounting, what is high efficiency, high output, and low cost has become possible, the influence which gives to industry is large.

In this invention, the sintered compact which comprises an aluminum nitride as the main ingredients and has optical permeability usually shows a permeability in the light of a wavelength not less than 200 nm.

As illustrated in FIG. 95, it was confirmed that there is a tendency whose optical permeability starts to be shown in the light of the range of 200 nm-250 nm wavelength, goes up rapidly in the light of the range of 250 nm-350 nm wavelength, and will be mostly fixed in the light of 350 nm-400 nm or more wavelength.

Unless reference is made especially in this invention, the optical transmissivity of the sintered compact which comprises an aluminum nitride as the main ingredients is “the optical transmissivity of the range of 200 nm-800 nm wavelength”, though it means the transmissivity measured in the light with a wavelength 605 nm unless especially it refuses, it can distinguish on behalf of the optical permeability ability of the sintered compact according to this invention which comprises an aluminum nitride as the main ingredients even if it uses the transmissivity in the light with a wavelength 605 nm.

Speaking more concretely, unless reference is made especially in this invention, optical transmissivity not less than 1% is the transmissivity in the light with a wavelength 605 mn. Although such a sintered compact which comprises an aluminum nitride as the main ingredients and has the optical transmissivity not less than 1% does not necessarily have transmissivity not less than 1% to the light of the range of 200 nm-800 nm wavelength except the wavelength of 605 nm, luminescence from this light emitting device that penetrated the substrate can be emitted now to the substrate exterior by using this sintered compact which comprises an aluminum nitride as the main ingredients as a substrate for light emitting device mounting.

In this invention, as for the sintered compact which comprises an aluminum nitride as the main ingredients and is used as a substrate for mounting the light emitting device which comprises as the main ingredients at least one or more materials selected from a gallium nitride, an indium nitride, and an aluminum nitride, what has the transmissivity not less than 1% to the light of the range of 200 nm-800 nm wavelength is desirable.

Unless reference is made especially in this invention, as mentioned above, the optical transmissivity of the sintered compact which comprises an aluminum nitride as the main ingredients means the transmissivity measured by the light with a wavelength 605 nm.

In this invention, although the sintered compact which comprises an aluminum nitride as the main ingredients and has high AlN purity and whose aluminum nitride particle grew up is preferred as a substrate for light emitting device mounting, even if the purity of AlN is not necessarily high, that is, even if it is the sintered compacts which comprise an aluminum nitride as the main ingredients in which comparatively many ingredients, such as sintering aid, such as a rare-earth compound and an alkaline earth metal compound, or oxygen, or ingredients used as a firing temperature reduction-ized agent, such as an alkali metal and silicon, or the metal ingredients, such as Mo, W, V, Nb, Ta, and Ti, and carbon, which are used as a black-ized agent, or unescapable metal ingredients other than Mo, W, V, Nb, Ta, and Ti, or the above-mentioned metal ingredients other than aluminum and silicon, or the compound containing carbon, etc., remain, if an aluminum nitride particle has grown up, it can become good substrate for light emitting device mounting.

As mentioned above, such a sintered compact which comprises an aluminum nitride as the main ingredients and contains comparatively many ingredients other than an aluminum nitride and whose aluminum nitride particles have grown up is producible by the firing condition of comparatively high temperature and a long time at not less than 1750 degrees C. for not less than 3 hours in the non-oxidizing atmosphere which does not contain reduction nature ingredients as much as possible.

That is, in the substrate for light emitting device mounting according to this invention, in what is an average of not less than 1 μm of the size of an aluminum nitride particle contained inside such above-mentioned sintered compact which comprises an aluminum nitride as the main ingredients containing comparatively many ingredients, such as a rare earth element compound, an alkaline-earth-metals compound, oxygen, an alkaline metal, silicon, metal ingredients, such as Mo, W, V, Nb, Ta, and Ti, carbon, unescapable metal ingredients other than Mo, W, V, Nb, Ta, and Ti, ALON, and metal ingredients other than the above-mentioned aluminum, etc., what is the optical transmissivity not less than 1% is easy to be obtained.

In the substrate for light emitting device mounting according to this invention, what is the optical transmissivity not less than 5% is easy to be obtained in the sintered compact which contains comparatively many ingredients other than an aluminum nitride and whose size of an aluminum nitride particle grew up into an average of not less than 5 μm.

In the substrate for light emitting device mounting according to this invention, what is the optical transmissivity not less than 10% is easy to be obtained in the sintered compact which contains comparatively many ingredients other than an aluminum nitride and whose size of an aluminum nitride particle grew up into an average of not less than 8 μm.

In the substrate for light emitting device mounting according to this invention, what is the optical transmissivity not less than 20% is easy to be obtained in the sintered compact which contains comparatively many ingredients other than an aluminum nitride and whose size of an aluminum nitride particle grew up into an average of not less than 15 μm.

In the substrate for light emitting device mounting according to this invention, what is the optical transmissivity not less than 30% is easy to be obtained in the sintered compact which contains comparatively many ingredients other than an aluminum nitride and whose size of an aluminum nitride particle grew up into an average of not less than 25 μm.

It is guessed that since the area of the grain boundary of an aluminum nitride crystal grain decreases, and the influence of a grain boundary decreases if the size of an aluminum nitride particle inside a sintered compact becomes large, the light which is scattered and absorbed in a grain boundary decreases, so optical transmissivity improves.

In this invention, although that whose aluminum nitride particle grew up is manufactured by raising the firing temperature or by lengthening firing time in the non-oxidizing atmosphere which does not contain reduction nature ingredients as much as possible also in the sintered compact which comprises an aluminum nitride as the main ingredients containing comparatively many ingredients, such as a rare earth element compound, an alkaline-earth-metals compound, oxygen, an alkaline metal, silicon, metal ingredients, such as Mo, W, V, Nb, Ta, and Ti, carbon, unescapable metal ingredients other than Mo, W, V, Nb, Ta, and Ti, ALON, and metal ingredients other than the above-mentioned aluminum, etc., the size of the grown aluminum nitride particle of this sintered compact is usually an average of not less than 5 μm.

Usually, if firing temperature is raised or firing time is lengthened, the size of an aluminum nitride particle in a sintered compact will also increase to an average of not less than 8 μm, furthermore to an average of not less than 15 μm, still furthermore to an average of not less than 25 μm, on an experiment, what is about an average of 100 μm as size of an aluminum nitride particle is also obtained.

In this invention, as above-mentioned, by raising the firing temperature or lengthening firing time in a non-oxidizing atmosphere which does not contain reduction nature ingredients as much as possible, although what has any composition can be used if it is what comprises an aluminum nitride as the main ingredients (for example, what contains not less than 50 volume % as AlN) as the sintered compact which comprises an aluminum nitride as the main ingredients and contains comparatively lots of ingredients, such as a rare earth element, an alkaline earth metal, oxygen, an alkali metal, silicon, the metal ingredients, such as Mo, W, V, Nb, Ta, and Ti, etc., carbon, unescapable metal ingredients other than Mo, W, V, Nb, Ta, and Ti, ALON, metal ingredients other than the above-mentioned aluminum, etc., and whose aluminum nitride particle grows, among them it is preferred to use the thing of a composition in which the content of at least one or more compounds selected from a rare earth element or an alkaline earth metal is not more than 20 volume % by oxide conversion, oxygen content is not more than 10 weight %, content of at least one or more of compounds selected from an alkali metal or silicon is not more than 5 volume % by oxide conversion, content of compounds which contain at least one or more elements selected from Mo, W, V, Nb, Ta, Ti, and carbon is not more than 5 volume % by element conversion, content of ingredients which contain transition metals other than a rare earth element and Mo, W, V, Nb, Ta, and Ti is a total of not more than 1 weight % by element conversion, and content of ALON is not more than 20%.

If it is the above composition, even if it is the sintered compact which comprises an aluminum nitride as the main ingredients and whose purity of AlN is not necessarily high, that whose particle of an aluminum nitride grew up can be used as an excellent substrate for mounting the light emitting device which comprises as the main ingredients at least one or more materials selected from a gallium nitride, an indium nitride, and an aluminum nitride.

As mentioned above, the sintered compact which comprises an aluminum nitride as the main ingredients and contains comparatively lots of ingredients, such as a rare earth element compounds, an alkaline earth metals compounds, oxygen, an alkali metal, silicon, the metal ingredients, such as Mo, W, V, Nb, Ta, and Ti, etc., carbon, unescapable metal ingredients other than Mo, W, V, Nb, Ta, and Ti, ALON, metal ingredients other than the above-mentioned aluminum, etc., and whose aluminum nitride particle grows by raising the firing temperature or lengthening firing time is easy to be obtained by firing in a non-oxidizing atmosphere which does not contain reduction nature ingredients as much as possible.

In this invention, when manufacturing the substrate for mounting the light emitting device which comprises as the main ingredients at least one or more materials selected from a gallium nitride, an indium nitride, and an aluminum nitride, in order to raise the optical transmissivity of the above-mentioned sintered compact which comprises an aluminum nitride as the main ingredients and is made into high purity anything can be used as the form of the powder compact or sintered compact which are used for firing, for example, the cube and rectangular parallelepiped, or the cylindrical one, but it is preferred to use what beforehand has the shape of a board which is easy to process it in the shape of a substrate.

If it is the same volume, it is preferred to use what has bigger surface area than the shape of block, such as a cube, a rectangular parallelepiped, or the shape of a cylinder.

In the form of the above-mentioned powder compact or sintered compact which are used for firing, it is desirable to use that whose one-side size is not more than 8 mm in order to raise the optical transmissivity of the sintered compact which comprises an aluminum nitride as the main ingredients and is made into high purity.

Furthermore, it is more preferred to use that whose above-mentioned size of one side is not more than 5 mm, it is still more preferred to use that whose size of one side is not more than 2.5 mm, it is most preferred to use that whose size of one side is not more than 1 mm.

When the form of the above-mentioned powder compact or sintered compact which are used for firing is board-like, it is desirable to use what is not more than 8 mm of the thickness in order to raise the optical transmissivity of the sintered compact which comprises an aluminum nitride as the main ingredients and is made into high purity.

Furthermore, as for the thickness of a board-like powder compact or a sintered compact, it is more preferred to use what is not more than 5 mm, it is still more preferred to use what is the thickness not more than 2.5 mm, and it is most preferred to use what is the thickness not more than 1 mm.

If what was shown above is described concretely, for example, even if it is the sintered compact whose composition is same and which is an AlN single phase substantially, optical transmissivity will lower in the case of the sintered compact which comprises an aluminum nitride as the main ingredients and which is made into high purity and was manufactured by using the powder compact or sintered compact which are the above-mentioned cube and rectangular parallelepiped or the shape of cylinder, or whose one side is more than 8 mm compared with what is manufactured by using the powder compact and sintered compact which are the shape of a board or whose one side is not more than 8 mm, discoloration-ization may increase and optical transmissivity may lower further according to the case.

In order to mount the light emitting device which comprises as the main ingredients at least one or more materials selected from a gallium nitride, an indium nitride, and an aluminum nitride, the degree of smoothness of the surface of the substrate according to this invention which consists of a sintered compact which comprises an aluminum nitride as the main ingredients (namely, substrate for light emitting device mounting) can use arbitrary things.

Even if, for example, average surface roughness Ra is in the state not more than 100 nm where a smooth nature is comparatively high in the substrate surface, the reflectance of this substrate which consists of a sintered compact which comprises an aluminum nitride as the main ingredients to luminescence from the light emitting device is comparatively as low as below a maximum of about 15%.

In order to make reflectance of the above-mentioned substrate not more than 15%, it is preferred that average surface roughness Ra is set to not less than 100 nm.

In order to make reflectance of the above-mentioned substrate not more than 10%, it is preferred that average surface roughness Ra is set to not less than 2000 nm.

In this invention, the substrate for light emitting device mounting which has above-mentioned average surface roughness Ra can be obtained by the as-fired (as-fire) surface and lap grinding, brush polish, and specular polish surface etc. of the sintered compact which comprises an aluminum nitride as the main ingredients.

The substrate for light emitting device mounting which has the average surface roughness not less than Ra 2000 nm can be obtained by the as-fired (as-fire) surface and lap grinding, and brush polish surface etc. of the sintered compact which comprises an aluminum nitride as the main ingredients.

The substrate for light emitting device mounting which has the average surface roughness not more than Ra 100 nm can be obtained by the as-fired (as-fire) surface and lap grinding, and brush polish surface etc. of the sintered compact which comprises an aluminum nitride as the main ingredients.

The substrate for light emitting device mounting which has the average surface roughness not less than Ra 100 nm can be obtained by the as-fired (as-fire) surface and brush polish, and specular polish surface etc. of the sintered compact which comprises an aluminum nitride as the main ingredients.

In this invention, in the substrate for light emitting device mounting which consists of a sintered compact which comprises an aluminum nitride as the main ingredients, when the luminescence from the light emitting device which comprises as the main ingredients at least one or more materials selected from a gallium nitride, an indium nitride, and an aluminum nitride is emitted to the substrate exterior, it becomes important to control reflectance by controlling the surface state and surface smooth nature of the substrate for light emitting device mounting which consists of a sintered compact which comprises an aluminum nitride as the main ingredients in order to make the direction of this emitted light easy to control.

This surface state and surface smooth nature are the same even when the sintered compact which comprises an aluminum nitride as the main ingredients and whose optical transmissivity was raised is made into a substrate for light emitting device mounting, for example, the sintered compact which comprises an aluminum nitride as the main ingredients whose aluminum nitride particle grew up greatly and which raised the AlN purity and is obtained according to the firing at the temperature not less than 1750 degrees C. for comparatively long time not less than 3 hours, or the sintered compact which comprises an aluminum nitride as the main ingredients and whose aluminum nitride particle grew up greatly and does not raise the AlN purity comparatively highly, etc.

In order to raise the transmissivity of the substrate which consists of a sintered compact which comprises an aluminum nitride as the main ingredients, it is also effective to make the thickness of a substrate thin besides improving the characteristic of the sintered compact itself, such as the chemical composition and microstructure of a sintered compact.

If the thickness of a substrate is not more than 8.0 mm, permeability can be maintained to the light of the range of 200 nm-800 nm wavelength.

That permeability is maintainable means that transmissivity is not less than 1%, even if the thickness of the substrate which consists of a sintered compact which comprises as the main ingredients an aluminum nitride is 8.0 mm.

Even if the transmissivity measured by using the substrate which consists of a sintered compact which comprises an aluminum nitride as the main ingredients and whose thickness is 0.5 mm is as high as 60-80% to the light of the range of 200 nm-800 nm wavelength, if the thickness of a substrate becomes thick, transmissivity decreases.

For example, when the transmissivity measured by using the substrate with 0.5 mm thickness is 80% to the light of the range of 200 nm-800 nm wavelength, even if the thickness is 8.0 mm, transmissivity is not less than 1% in the light of the range of 200 nm-800 nm wavelength.

If the thickness of a substrate is not more than 5.0 mm, transmissivity not less than 5% is obtained.

If the thickness of a substrate is not more than 2.5 mm, transmissivity not less than 10% is obtained.

If the thickness of a substrate is not more than 1.0 mm, transmissivity not less than 60% is obtained.

If the thickness of a substrate becomes thin with not more than 0.2 mm, transmissivity not less than 90% is obtained.

When the thickness of a substrate is not more than 0.05 mm, transmissivity not less than 95% is obtained.

When the transmissivity measured by using the substrate with 0.5 mm thickness is 1.0% to the light of the range of 200 nm-800 nm wavelength, if the thickness becomes thin to 0.2 mm, what is transmissivity not less than 10% is obtained.

When the thickness of a substrate is not more than 0.1 mm, transmissivity not less than 20% is obtained.

When the thickness of a substrate is not more than 0.05 mm, transmissivity not less than 40% is obtained.

Thus, in the substrate which consists of a sintered compact which comprises an aluminum nitride as the main ingredients and has high transmissivity not less than 60% to the light of the range of 200 nm-800 nm wavelength, it has the transmissivity not less than 30% in case of thickness not more than 1.0 mm, and in case of thickness not more than 0.2 mm it is easy to obtain the thing which is the transmissivity not less than 90% and which is almost transparent.

What has the transmissivity near 100% substantially is obtained.

Usually, although transmissivity has an increasing tendency so thin the thickness of a substrate is thin, since mechanical strength becomes small, there is a defect that a crack and a chip begin to arise, at the time of the work in the case of mounting the light emitting device which comprises as the main ingredients at least one or more materials selected from a gallium nitride, an indium nitride, and an aluminum nitride on the substrate, as for the thickness of a substrate, it is preferred that it is not less than 0.01 mm, it is more preferred that it is not less than 0.02 mm, and it is still more preferred that it is not less than 0.05 mm.

As mentioned above, when the substrate according to this invention which consists of a sintered compact which comprises as the main ingredients an aluminum nitride is used as a substrate for mounting a light emitting device which comprises as the main ingredients at least one or more materials selected from a gallium nitride, an indium nitride, and an aluminum nitride, it is preferred that the thickness of a substrate is not more than 8 mm, and it is more preferred that it is not more than 5.0 mm, from the viewpoint of an optical permeability (namely, predominance when forming a light emitting device on the substrate according to this invention which consists of a sintered compact which comprises an aluminum nitride as the main ingredients).

Moreover, it is still more preferred that the thickness of a substrate is not more than 2.5 mm, and it is most preferred that the thickness of a substrate is not more than 1.0 mm.

In the substrate of such thickness, it is preferred that it is not less than 0.01 mm from a viewpoint of mechanical strength, it is more preferred that it is not less than 0.02 mm, and it is still more preferred that it is not less than 0.05 mm.

A conduction via can be provided to the substrate for light emitting device mounting according to this invention which consists of a sintered compact which comprises an aluminum nitride as the main ingredients.

This conduction via is usually provided into the inside of the substrate for light emitting device mounting which consists of a sintered compact which comprises an aluminum nitride as the main ingredients.

This conduction via not only connects electrically the surface (namely, the surface of the side on which the light emitting device is mounted and the surface of the opposite side on which the light emitting device is mounted) of the upper and lower sides of a substrate, but also connects the electric circuits inside this substrate electrically, when the electric circuit is formed in the inside of a substrate, or can be suitably provided, also when connecting electrically the electric circuit inside this substrate, the surface of the side of light emitting device mounting of a substrate, the surface of the opposite side of light emitting device mounting of a substrate, and the external side of a substrate.

The conduction via can form easily by the suitable methods, for example, a through hole (through hole) is formed in ceramic powder compacts, such as a green sheet which comprises an aluminum nitride as the main ingredients, the conductive powder which comprises a metal etc. as the main ingredients is beforehand put in there, then co-firing is carried out, the substrate which consists of a sintered compact which comprises an aluminum nitride as the main ingredients whose through hole was formed is submerged into a fusion metal, and a fusion metal is introduced into this through hole portion, conductive paste is introduced into the through hole of a substrate, and it heats or fires.

There are what were illustrated with the mark 40 in each figure of FIG. 75, FIG. 76, FIG. 81, FIG. 82, FIG. 83, and FIG. 84 as a conduction via according to this invention.

This conduction via is formed in the inside of the substrate according to this invention (shown by a mark 20 or the mark 30) which consists of a sintered compact which comprises an aluminum nitride as the main ingredients and is used as an object for light emitting device mounting.

In this invention, the magnitude and form of a conduction via can be selected suitably, even if it is the thing of what kind of magnitude, or even if it is the thing of what kind of form, what is necessary is to just be devised so that the good optical permeability of the sintered compact which comprises an aluminum nitride as the main ingredients may not be prevented as much as possible.

Usually, in order not to prevent the good optical permeability of the sintered compact which comprises an aluminum nitride as the main ingredients, as for the size of a conduction via, it is preferred that it is not more than 500 μm.

If the size of a conduction via is not more than 500 μm, it will be hard coming to generate reduction of the brightness by the shadow of a conduction via etc. in luminescence from the light emitting device which penetrates the inside of a substrate and is emitted to the exterior.

That such a phenomenon arises is considered because luminescence from the light emitting device which is emitted to this substrate exterior is the scattered light scattered about by the aluminum nitride polycrystal particle inside a substrate.

Usually, if it takes into consideration making easy the processability to the green sheet when forming the sintered compact which comprises an aluminum nitride as the main ingredients and sintered compact, as for the size of a conduction via, it is preferred that it is not more than 250 μm.

If the size of a conduction via is not more than 250 μm, it will be harder to produce reduction of the brightness by the shadow of a conduction via etc. in luminescence from the light emitting device which penetrates the inside of a substrate and is emitted to the exterior.

It is more preferred that it is not more than 100 μm as a size of a conduction via.

If the size of a conduction via is not more than 100 μm, it will be harder to produce reduction of the brightness by the shadow of a conduction via etc. in luminescence from the light emitting device which penetrates the inside of a substrate and is emitted to the exterior.

It is still more preferred that it is not more than 50 μm as a size of a conduction via. Since it will further be hard coming to generate reduction of the brightness by the shadow of a conduction via etc. in luminescence from the light emitting device which penetrates the inside of a substrate and is emitted to the exterior if the size of a conduction via is not more than 50 μm, it is desirable.

If it takes into consideration making easy the processability to the green sheet when forming the sintered compact which comprises an aluminum nitride as the main ingredients and sintered compact, as for the size of a conduction via, it is most preferred that it is not more than 25 μm.

If the size of a conduction via is not more than 25 μm, it will almost be hard coming to generate reduction of the brightness by the shadow of a conduction via etc. in luminescence from the light emitting device which penetrates the inside of a substrate and is emitted to the exterior.

In this invention, the size of a conduction via is indicated with the maximum size of a section. That is, when a section is round shape with the diameter of 200 μm, the size of a conduction via is 200 μm as it is, and in the case of the square of one-side 150 μm, the size of a conduction via is 212 μm.

Although the section form of a conduction via can use arbitrary things, it is preferred that a section uses a circular thing from a point of processability.

In each figure of FIG. 75, FIG. 76, FIG. 81, FIG. 82, FIG. 83, and FIG. 84, although what formed two conduction vias is illustrated, into the substrate for light emitting device mounting according to this invention, the conduction via of one piece or more than three-piece plurality can be provided suitably.

Even if it has provided many conduction vias, as for the optical permeability of the substrate for light emitting device mounting according to this invention, since the sintered compact which comprises an aluminum nitride as the main ingredients and in which the penetration light is easy to become into a scattered light is used as the material of this substrate, it is hard to produce almost reduction of the brightness of the penetration light by shadows of a conduction via etc.

When a light emitting device is mounted on the substrate which has this conduction via, since the electric power or the electric signal for driving the light emitting device can supply from the substrate surface of the opposite side on which this light emitting device was mounted via this conduction via inside a substrate, a compact design as a substrate for light emitting device mounting can be performed.

In order to form a conduction via, the laser processing method by carbon dioxide gas laser, YAG laser or an excimer laser, etc., for example, is preferred as a fine drilling processing method in addition to the punching method using the needle usually performed as a method of forming a through hole in ceramic powder compacts, such as a green sheet which comprises an aluminum nitride as the main ingredients as mentioned above.

The above-mentioned laser processing method is suitable also for the punch to the sintered compact after firing.

The conduction via of not more than 50 μm and about up to 1 μm can be formed by using the laser processing method.

As the size of the conduction via formed in the sintered compact which comprises an aluminum nitride as the main ingredients and is obtained by firing becomes still smaller from 50 μm and 1 μm is approached, it is almost hard coming to generate reduction of the brightness by the shadow of a conduction via etc. in luminescence from the light emitting device which penetrates the inside of a substrate and is emitted to the exterior, it is preferred especially.

Anything can be used as a conductive material used for a conduction via, especially if it is easy to combine with the sintered compact which comprises an aluminum nitride as the main ingredients and is forming the substrate for light emitting device mounting, further if it is hard to generate injury of the good optical permeability of this sintered compact which comprises an aluminum nitride as the main ingredients by arising of a harmful reaction with the sintered compact which comprises an aluminum nitride as the main ingredients while forming this conductive material, and the optical intensity cannot fall easily even after the light emitted from a light emitting device penetrates this sintered compact, any material can be used.

Such a material comprises as the main ingredients at least one or more elements selected from gold, silver, copper, aluminum, iron, cobalt, nickel, ruthenium, rhodium, palladium, osmium, iridium, platinum, tungsten, molybdenum, titanium nitride, and zirconium nitride etc., for example.

If it is the conduction via which consists of such a material, it will be easy to combine with the above-mentioned sintered compact which comprises an aluminum nitride as the main ingredients, and will be hard to prevent the good optical permeability of this sintered compact which comprises an aluminum nitride as the main ingredients further.

As for what added at least one or more ingredients selected from an aluminum nitride, a silicon carbide, a silicon nitride, a zinc oxide, a beryllium oxide, an aluminum oxide, a rare earth element compound, and an alkaline-earth-metals compound, etc. to the above-mentioned main ingredients as a material of a conduction via, not only it is easy to combine with the sintered compact which comprises an aluminum nitride as the main ingredients and is a substrate but also it becomes harder to prevent the good optical permeability of this sintered compact which comprises an aluminum nitride as the main ingredients.

In the material of the above-mentioned conduction via, what comprises as the main ingredients at least one or more elements selected from gold, silver, copper, palladium, platinum, molybdenum, tungsten, titanium nitride, and zirconium nitride not only is easy to combine with the material of the aluminum nitride sintered compact etc. which is a substrate but also becomes furthermore hard to prevent the good optical permeability of this sintered compact which comprises an aluminum nitride as the main ingredients.

The thing which comprises as the main ingredients at least one or more ingredients selected from gold, silver, copper, palladium, platinum, molybdenum, tungsten, titanium nitride, and zirconium nitride and contains furthermore at least one or more ingredients selected from an aluminum nitride, an aluminum oxide, ae rare earth element compound, and an alkaline-earth-metals compound not only is easy to combine with the sintered compact which comprises an aluminum nitride as the main ingredients but also becomes furthermore hard to prevent the good optical permeability of this sintered compact which comprises an aluminum nitride as the main ingredients.

As for the content of at least one or more ingredients which were selected from the aluminum nitride, a silicon carbide, a silicon nitride, a zinc oxide, a beryllium oxide, an aluminum oxide, a rare earth element compound, and an alkaline-earth-metals compound and is contained in the material which forms this conduction via, it is preferably that it is a total of not more than 30 weight %, since the electric resistivity in room temperature of the material used for this conduction via tends to become not more than 1×10⁻³ Ω·cm, it is desirable.

If it is more than 30 weight %, since the electric resistivity in room temperature will tend to become higher than 1×10⁻³ Ω·cm, it is not desirable.

A more desirable content is not more than 20 weight %, and since the electric resistivity in room temperature tends to become not more than 1×10⁻⁴Ω·cm, it is more preferred.

A furthermore desirable content is not more than 10 weight %, and since the electric resistivity in room temperature tends to become not more than 5×10⁻⁵ Ω·cm, it is more preferred.

The most desirable content is not more than 5 weight %, and since the electric resistivity in room temperature of this material tends to become not more than 1×10⁻⁵ Ω·cm, it is preferred.

The molybdenum and tungsten which are used as the main ingredients of the above-mentioned conduction via can be used also as not only metal but also carbide, or nitride.

Thus, among the material of a conduction via, the thing which comprises as the main ingredients at least one or more elements selected from gold, silver, copper, palladium, platinum, molybdenum, tungsten, titanium nitride, and zirconium nitride or the thing which comprises as the main ingredients at least one or more elements selected from gold, silver, copper, palladium, platinum, molybdenum, tungsten, titanium nitride, and zirconium nitride and contains furthermore at least one or more ingredients selected from an aluminum nitride, an aluminum oxide, a rare earth element compound, and an alkaline-earth-metals compound, not only are easy to combine with the sintered compact which comprises an aluminum nitride as the main ingredients but also become furthermore hard to prevent the good optical permeability of this sintered compact which comprises an aluminum nitride as the main ingredients, but the reason in which the optical intensity becomes hard to lower even after the light emitted from a light emitting device penetrates this sintered compact is not necessarily clear, it seems that it is because it has the quality which is hard to react with the sintered compact which comprises an aluminum nitride as the main ingredients, and easier to generate anchor effect in the through hole of this sintered compact which comprises an aluminum nitride as the main ingredients in spite of being hard to react.

The rare earth element compound used for the above-mentioned conduction via is a rare earth element, such as Sc, Y, La, Ce, Pr, Nd, Sm, Eu, Gd, Dy, Ho, Er, Yb, and Lu, and rare earth element oxides, such as Sc₂O₃, Y₂O₃, La₂O₃, CeO₂ and Pr₆O₁₁, Nd₂O₃, Sm₂O₃, Eu₂O₃, Gd₂O₃, Dy₂O₃, Ho₂O₃, Er₂O₃, Yb₂O₃, and Lu₂O₃, or, in addition, various rare earth element compounds, such as inorganic rare earth compounds, such as carbonate, nitrate, sulfate, and chloride, organic rare earth compounds, such as acetate, oxalate, and citrate etc., containing Sc, Y, La, Ce, Pr, Nd, Sm, Eu, Gd, Dy, Ho, Er, Yb, Lu, etc., further the complex oxide containing various rare earth elements, such as 3Ln₂O₃.5Al₂O₃ of a garnet type crystal structure (for example, 3Y₂O₃.5Al₂O₃, Dy₂O₃.5Al.₂O₃, 3Ho₂O₃.5Al₂O₃, 3Er₂O₃.5Al₂O₃, 3Yb₂O₃.5Al₂O₃, etc.), Ln₂O₃.Al₂O₃of a perovskite type crystal structure (for example, YAlO₃, LaAlO₃, PrAlO₃, NdAlO₃, SmAlO₃, EuAlO₃, GdAlO₃, DyAlO₃, HoAlO₃, ErAlO₃, YbAlO₃, etc.), and monoclinic system crystal structure 2Ln₂O₃.Al₂O₃ (for example, 2Y₂O₃.Al₂O₃, 2Sm₂O₃.Al₂O₃, 2Eu₂O₃.Al₂O₃, 2Gd₂O₃.Al₂O₃, 2Dy₂O₃.Al₂O₃, 2Ho₂O₃.Al₂O₃, 2Er₂O₃.Al₂O₃, 2Yb₂O₃.Al₂O₃) etc., when a rare earth element is expressed with Ln.

The alkaline-earth-metals compound used for the above-mentioned conduction via is alkaline earth metals, such as Mg, Ca, Sr, and Ba, etc., and alkaline earth metal oxides, such as MgO, CaO, SrO, and BaO, etc., or, in addition, various alkaline earth metal compounds, such as inorganic alkaline earth metal compounds, such as carbonate, nitrate, sulfate, and chloride, organic alkaline earth metal compounds, such as acetate, oxalate, and citrate, containing Mg, Ca, Sr, and Ba, etc., and further the complex oxides which include an alkaline earth metal, such as 3AeO.Al₂O₃, Ae.Al₂O₃, Ae.2Al₂O₃, and Ae.6Al₂O₃, when an alkaline earth metal element is expressed with Ae.

In this invention, also in each material used for a conduction via other than the thing which comprises as at least one or more elements selected from gold, silver, copper, palladium, platinum, molybdenum, tungsten, titanium nitride, and zirconium nitride and contains furthermore at least one or more ingredients selected from an aluminum nitride, an aluminum oxide, a rare earth element compound, and an alkaline-earth-metals compound, if the electric resistivity has the conductivity of about not more than 1×10⁻³ Ω·cm in room temperature, it is preferred, it is more preferred that the electric resistivity is not more than 1×10⁻⁴ Ω·cm in room temperature, and it is still more preferred that the electric resistivity is not more than 1×10⁻⁵ Ω·cm in room temperature.

In this invention, when the substrate in which the above-mentioned conduction via is formed is the sintered compact which comprises an aluminum nitride as the main ingredients, it may be the thing which contains at least one or more of sintering aids, firing temperature reduction-ized agents, black-ized agents, unescapable impurities, ALON, etc., and as a crystal phase which was made into high purity it may be the thing which is what contains AlN not less than 95% or what contains AlN not less than 98% or what consists of an AlN single phase substantially, any sintered compact which comprises an aluminum nitride as the main ingredients can also be used.

As for the material of the conduction via formed in the sintered compact which comprises an aluminum nitride as the main ingredients, if the thing which comprises as the main ingredients at least one or more elements selected from gold, silver, copper, palladium, platinum, molybdenum, tungsten, titanium nitride, and zirconium nitride or the thing which comprises as the main ingredients at least one or more elements selected from gold, silver, copper, palladium, platinum, molybdenum, tungsten, titanium nitride, and zirconium nitride and contains furthermore at least one or more ingredients selected from an aluminum nitride, an aluminum oxide, a rare earth element compound, and an alkaline-earth-metals compound are used, since it hardly vaporizes also during the high temperature and prolonged heat treatment performed in order to make the sintered compact which comprises an aluminum nitride as the main ingredients high purity and to raise optical transmissivity, manufacture of the substrate which has a conduction via is attained easily, the excellent substrate with high thermal conductivity and optical permeability which can connect electrically the up-and-down surface of a substrate or connect the internal electric circuit and the substrate surface of a substrate and whose thermal expansion coefficient is close to the light emitting device which comprises as the main ingredients at least one or more materials selected from a gallium nitride, an indium nitride, and an aluminum nitride can be provided in low cost, the influence which gives to the industry is still larger.

In this invention, as a form of a conduction via, what is various forms, such as that whose conductive material is filled up densely in the through hole of a sintered compact where comprises an aluminum nitride as the main ingredients, and what formed a conductive material in the side wall of this through hole, can be used.

In it, what is so-called form of the filled via whose conductive material was formed in the dense state in the through hole is preferred, and there are many advantages, such as being easy to combine with the sintered compact which comprises an aluminum nitride as the main ingredients, or being hard to prevent the good optical permeability of this sintered compact which comprise an aluminum nitride as the main ingredients, etc.

By providing a conduction via, the up-and-down surface of the substrate for light emitting device mounting which consists of a sintered compact which comprises an aluminum nitride as the main ingredients and is originally an insulator electrically, or the internal electric circuit and the substrate surface of a substrate are connectable electrically.

When mounting a light emitting device by forming a conduction via in substrate for light emitting device mounting, a miniaturization and design flexibility of this substrate for light emitting device mounting increase, and it becomes advantageous.

An electric circuit can be provided to the substrate for light emitting device mounting according to this invention which consists of a sintered compact which comprises an aluminum nitride as the main ingredients.

This electric circuit is usually provided at the surface, or in the inside, or in the surface and inside simultaneously, in the substrate for light emitting device mounting which consists of a sintered compact which comprises an aluminum nitride as the main ingredients.

This electric circuit is usually provided in order to supply the electric signal and electric power for making a light emitting device drive.

The substrate for light emitting device mounting which has a multilayer electric circuit can be obtained by providing this electric circuit in the inside of a substrate, and connecting with a surface electric circuit using a conduction via. The substrate miniaturized by forming a multilayer electric circuit in substrate for light emitting device mounting can be obtained.

In this invention, metallizing for fixing and mounting a light emitting device on the light emitting device mounting portion of the substrate for light emitting device mounting which consists of a sintered compact which comprises an aluminum nitride as the main ingredients using connection material, such as braze material and conductive adhesives, is formed if needed.

Said metallizing for fixing and mounting a light emitting device on a substrate using connection material, such as braze material and conductive adhesives, is also contained in the electric circuit of this invention.

This metallizing not only fixes a light emitting device mechanically to the substrate for light emitting device mounting which consists of a sintered compact which comprises an aluminum nitride as the main ingredients but also can have together the function which connects with a light emitting device electrically and supplies an electric signal and electric power to a light emitting device.

In order to form an electric circuit in the inside of the substrate for light emitting device mounting which consists of a sintered compact which comprises an aluminum nitride as the main ingredients, the sintered compact which comprises an aluminum nitride as the main ingredients and whose electric circuit was formed in the inside by uniting a conductive material and the powder compact which comprises an aluminum nitride as the main ingredients and firing simultaneously is obtained by forming a circuit pattern in ceramic powder compacts, such as a green sheet which comprises an aluminum nitride as the main ingredients by conventional method, for example, using the paste which consists of a conductive material, and laminating two or more ceramic powder compacts, such as the above-mentioned green sheet, so that a circuit pattern may be arranged on an inside, and firing after performing drying and de-binder.

If the above-mentioned co-firing method is used, not only the substrate for light emitting device mounting in which the electric circuit was formed in the inside of a substrate is obtained but also the substrate for light emitting device mounting on which the electric circuit was formed at the surface of a substrate will be obtained.

Furthermore, if the above-mentioned co-firing method is used, the substrate for light emitting device mounting which has the multilayer electric circuit which formed the electric circuit simultaneously in the inside of a substrate and at the substrate surface will be obtained.

In this invention, anything can be used as a conductive material used for an electric circuit, especially if it is easy to combine with the sintered compact which comprises an aluminum nitride as the main ingredients and is forming the substrate for light emitting device mounting, further if it is hard to generate injury of the good optical permeability of this sintered compact which comprises an aluminum nitride as the main ingredients by arising of a harmful reaction with the sintered compact which comprises an aluminum nitride as the main ingredients while forming this conductive material, and the optical intensity cannot fall easily even after the light emitted from a light emitting device penetrates this sintered compact, any material can be used.

As such a material, for example, it is a conductive material which comprises as the main ingredients metal, an alloy, or a metal nitride etc. which comprises as the main ingredients at least one or more elements selected from gold, silver, copper, aluminum, iron, cobalt, nickel, ruthenium, a ruthenium oxide, rhodium, palladium, osmium, iridium, platinum, tungsten, molybdenum, chromium, titanium, zirconium, titanium nitride, zirconium nitride, tantalum nitride, and nickel chromium alloy, etc.

If an electric circuit is formed with such a conductive material, it is easy to combine with the above-mentioned sintered compact which comprises an aluminum nitride as the main ingredients, and it is hard to prevent the good optical permeability of this sintered compact which comprises an aluminum nitride as the main ingredients, optical intensity cannot lower easily even after the light emitted from a light emitting device penetrates this sintered compact.

As a material of an electric circuit, as for what added to the above-mentioned main ingredients at least one or more ingredients selected from an aluminum nitride, a silicon carbide, a silicon nitride, a zinc oxide, a beryllium oxide, an aluminum oxide, a rare earth element compound, a alkaline-earth-metals compound, etc., it is not only easy to combine with the sintered compact of a substrate which comprises an aluminum nitride as the main ingredients but also harder to come to prevent the good optical permeability of this sintered compact which comprises an aluminum nitride as the main ingredients.

In the above-mentioned material for electric circuit formation, the thing which comprises as the main ingredients at least one or more elements selected from gold, silver, copper, nickel, palladium, platinum, molybdenum, tungsten, titanium nitride, and zirconium nitride not only is easy to combine with the sintered compact which is a substrate and which comprises an aluminum nitride as the main ingredients but also becomes further hard to prevent the good optical permeability of this sintered compact which comprises an aluminum nitride as the main ingredients.

The thing which comprises as the main ingredients at least one or more elements selected from gold, silver, copper, nickel, palladium, platinum, molybdenum, tungsten, titanium nitride, and zirconium nitride and contains furthermore at least one or more ingredients selected from an aluminum nitride, an aluminum oxide, a rare earth element compound, and a alkaline-earth-metals compound not only is easy to combine with the sintered compact which comprises an aluminum nitride as the main ingredients but also becomes furthermore hard to prevent the good optical permeability of this sintered compact which comprises an aluminum nitride as the main ingredients.

In this invention, by using the above-illustrated conductive material, an electric circuit processes into pattern form according to necessity, and is formed.

Although the form can be chosen arbitrarily, for example, when it is formed in the portion in which a light emitting device is mounted, it is the same as a light emitting device, or what is somewhat large form is used.

That is, when the size of a light emitting device is 3 mm×3 mm, a 3 mm×3 mm-5 mm×5 mm comparatively big plate-like pattern is used.

When forming an electric circuit as a line, and a fine pattern is required, what is the size of about 5 μm-20 μm as line and space can form by using methods, such as the co-firing method, and the thick film printing method, and the thin film method, by using processing technology and processing machines, such as optical lithography, and laser or ion milling.

In this invention, even if an electric circuit is the like pattern of a comparatively big size from a fine line pattern, it is hard to prevent the good optical permeability of the sintered compact which comprises an aluminum nitride as the main ingredients.

An electric circuit can be formed in the inside of a sintered compact which comprises an aluminum nitride as the main ingredients or on the sintered compact surface by the methods, such as forming by co-firing using such conductive material, or printing and joining such conductive material as a thick film afterwards on the sintered compact which comprises an aluminum nitride as the main ingredients and which once fires and is obtained, or forming by pasting up as conductive adhesives containing organic resin, forming as a thin film by sputter, vapor deposition, or ion-plating.

In this invention, the sintered compact which comprises an aluminum nitride as the main ingredients and which is obtained by once firing also includes the thing whose electric circuit was formed by co-firing on the surface or in the inside or in both of the surface and inside, or the thing whose conduction via was formed, or the thing whose electric circuit was formed on the surface or in the inside or in both of the surface and inside, and the conduction via was formed furthermore by co-firing.

As for the content of at least one or more ingredients which was selected from an aluminum nitride, a silicon carbide, a silicon nitride, a zinc oxide, a beryllium oxide, an aluminum oxide, a rare earth element compound, and an alkaline-earth-metals compound and are contained in the material used in order to form the above-mentioned electric circuit, it is preferred that it is a total of not more than 30 weight %, since the electric resistivity in room temperature of the material used for this electric circuit tends to become not more than 1×10⁻³ Ω·cm, it is desirable.

Since the electric resistivity in room temperature will tend to become higher than 1×10⁻³ Ω·cm if it is more than 30 weight %, it is not desirable.

A more desirable content is not more than 20 weight %, since the electric resistivity in room temperature tends to become not more than 1×10⁻⁴ Ω·cm, it is more preferred.

A furthermore desirable content is not more than 10 weight %, since the electric resistivity in room temperature tends to become not more than 5×10⁻⁵ Ω·cm, it is still more preferred.

The most desirable content is not more than 5 weight %, since the electric resistivity in room temperature tends to become not more than 1×10⁻⁵ Ω·cm, it is preferred.

The molybdenum and tungsten which are used as the main ingredients of the above-mentioned conduction via can be used not only as metal but also as carbide, or nitride.

Thus, in the material of a conduction via, the thing which comprises as the main ingredients at least one or more elements selected from gold, silver, copper, palladium, platinum, molybdenum, tungsten, titanium nitride, and zirconium nitride or the thing which comprises as the main ingredients at least one or more elements selected from gold, silver, copper, palladium, platinum, molybdenum, tungsten, titanium nitride, and zirconium nitride and contains furthermore at least one or more ingredients selected from an aluminum nitride, an aluminum oxide, a rare earth element compound, and an alkaline-earth-metals compound not only are easy to combine with the sintered compact which comprises an aluminum nitride as the main ingredients but also become furthermore hard to prevent the good optical permeability of this sintered compact which comprises an aluminum nitride as the main ingredients, but the reason is not necessarily clear, it seems that it is because it has the quality which is hard to react with the sintered compact which comprises an aluminum nitride as the main ingredients, and easier to generate anchor effect in the through hole of this sintered compact which comprises an aluminum nitride as the main ingredients in spite of being hard to react.

When an electric circuit is formed in the inside of a sintered compact, it is preferred to form an electric circuit in the inside of this sintered compact by the co-firing method with the sintered compact which comprises an aluminum nitride as the main ingredients by choosing tungsten, molybdenum, copper, etc. suitably, for example, as a metallizing ingredient among the above-mentioned conductive material.

If the co-firing method is used, the electric circuit can be formed also on the surface of the sintered compact which comprises an aluminum nitride as the main ingredients, and the substrate in which the multilayer electric circuit was formed easily can be manufactured.

If the method of joining a conductive material afterwards to the sintered compact which comprises an aluminum nitride as the main ingredients and which once fires and is obtained is used, there is an advantage that an electric circuit can be formed comparatively easily, such as printing the material of low resistance which comprises gold, silver, copper, platinum, palladium, etc. as the main ingredients as thick film metallizing, or pasting up as conductive adhesives.

When formation of an electric circuit is difficult by co-firing, the printing method, and the pasting-up method which used conductive adhesives, like, for example, aluminum, chromium, titanium, tantalum nitride, and nickel chromium alloy among the above-mentioned conductive material, an electric circuit can be formed on the sintered compact which comprises an aluminum nitride as the main ingredients as thin film metallizing by sputter, vapor deposition, or ion-plating.

As the electric circuit by the above-mentioned thin film, what was formed as the metallizing of one-layer structure which used only single material, for example, such as aluminum, tantalum nitride, nickel chromium alloy, and ruthenium oxide, to the sintered compact which comprises an aluminum nitride as the main ingredients can be used.

In addition to this, what is the thin film multilayer structure which used chromium, titanium, zirconium, etc. as an adhesion metal to the sintered compact which comprises an aluminum nitride as the main ingredients and which used further iron, cobalt, nickel, rhodium, palladium, osmium, iridium, platinum, molybdenum, tungsten, a titanium nitride, a zirconium nitride, etc. as a barrier metal suitably and formed furthermore low resistance material, such as gold, silver, copper, and aluminum suitably, for example, such as chromium/copper, titanium/molybdenum/gold, titanium/tungsten/nickel, titanium/tungsten/gold, titanium/platinum/gold, titanium/nickel/gold, zirconium/tungsten/gold, zirconium/platinum/gold, etc., can also be used as an electric circuit.

What formed tantalum nitride, nickel chromium alloy, and ruthenium oxide, etc. on the above-mentioned multilayer thin film can also be used.

As for the material which comprises as the main ingredients the above-mentioned tantalum nitride, nickel chromium alloy, and ruthenium oxide, etc., it is preferred that it will be used as a resistance object of an electric circuit.

Since a more fine electric circuit can be formed if a conductive material is formed by a thin film, smaller substrate for light emitting device mounting is easy to be obtained. When forming an electric circuit by the co-firing method, it is preferred to use what consists of material which comprises as the main ingredients at least one or more elements selected from copper, molybdenum, and tungsten as a conductive material.

If an electric circuit is formed with the above-illustrated conductive material, such as copper, molybdenum, and tungsten, it will be easy to combine with the sintered compact which comprises an aluminum nitride as the main ingredients, and will be hard to prevent the good optical permeability of this sintered compact which comprises an aluminum nitride as the main ingredients.

In the above illustrated conductive material, such as copper, molybdenum, and tungsten etc., as for what contains furthermore at least one or more ingredients selected from an aluminum nitride, an aluminum oxide, a rare earth element compound, and an alkaline-earth-metals compound, since not only it is easy to combine with the sintered compact of a substrate which comprises an aluminum nitride as the main ingredients but also it becomes further hard to prevent the good optical permeability of this sintered compact which comprises an aluminum nitride as the main ingredients, it is more desirable.

When an electric circuit is formed by junction by printing a conductive material as a thick film to the sintered compact which comprises an aluminum nitride as the main ingredients and is once fired or by adhering as conductive paste containing organic resin, it is preferred to use the material which comprises as the main ingredients at least one or more elements selected from gold, silver, copper, nickel, ruthenium, a ruthenium oxide, rhodium, palladium, osmium, iridium, platinum, molybdenum, and tungsten, for example, as a conductive material.

If an electric circuit is formed using this conductive material, it will be easy to combine with the sintered compact which comprises an aluminum nitride as the main ingredients, and will be hard to prevent the good optical permeability of this sintered compact which comprises an aluminum nitride as the main ingredients.

In the above illustrated conductive material, as for what contains furthermore at least one or more ingredients selected from an aluminum nitride, a silicon carbide, a silicon nitride, a zinc oxide, a beryllium oxide, an aluminum oxide, a rare earth element compound, and an alkaline-earth-metals compound, since not only it is easy to combine with the sintered compact of a substrate which comprises an aluminum nitride as the main ingredients but also it becomes further hard to prevent the good optical permeability of this sintered compact which comprises an aluminum nitride as the main ingredients, it is more desirable.

In this invention, the sintered compact which comprises an aluminum nitride as the main ingredients and which is obtained by once firing also includes the thing whose electric circuit was formed by co-firing on the surface or in the inside or in both of the surface and inside, or the thing whose conduction via was formed, or the thing whose electric circuit was formed on the surface or in the inside or in both of the surface and inside and the conduction via was formed furthermore by co-firing.

When an electric circuit is formed on the sintered compact which comprises an aluminum nitride as the main ingredients and is once fired by making a conductive material the thin film, as a conductive material, for example, it is preferred to use the material which comprises as the main ingredients at least one or more elements selected from gold, silver, copper, aluminum, nickel, ruthenium, a ruthenium oxide, rhodium, palladium, osmium, iridium, platinum, molybdenum, tungsten, chromium, titanium, a titanium nitride, zirconium nitride, tantalum nitride, and nickel chromium alloy.

If an electric circuit is formed using this conductive material, it will be easy to combine with the sintered compact which comprises an aluminum nitride as the main ingredients, and will be hard to prevent the good optical permeability of this sintered compact which comprises an aluminum nitride as the main ingredients.

The fine pattern whose line and space is about 5 μm can be formed using processing technology, such as optical lithography, and laser or ion milling, and a processing machine.

In the above illustrated conductive material, as for what contains furthermore at least one or more ingredients selected from an aluminum nitride, a silicon carbide, a silicon nitride, a zinc oxide, a beryllium oxide, an aluminum oxide, a rare earth element compound, and an alkaline-earth-metals compound, since not only it is easy to combine with the sintered compact of a substrate which comprises an aluminum nitride as the main ingredients but also it becomes further hard to prevent the good optical permeability of this sintered compact which comprises an aluminum nitride as the main ingredients, it is more desirable.

In this invention, the sintered compact which comprises an aluminum nitride as the main ingredients and which is obtained by once firing also includes the thing whose electric circuit was formed by co-firing on the surface or in the inside or in both of the surface and inside, or the thing whose conduction via was formed, or the thing whose electric circuit was formed on the surface or in the inside or in both of the surface and inside and the conduction via was formed furthermore by co-firing.

In this invention, as the method of forming an electric circuit, although there are at least three methods, such as the method by co-firing, or the method of printing or adhering a conductive material afterwards on the sintered compact which comprises an aluminum nitride as the main ingredients and which is once fired and is obtained, or the method of forming a conductive material as a thin film, as illustrated above, it can also carry out combining two or more of methods of it suitably.

If an electric circuit is performed combining two or more of the above mentioned methods, it will become possible to obtain more highly efficient substrate for light emitting device mounting by taking advantage of the strong point in each method.

For example, if the substrate for light emitting device mounting in which the electric circuit was formed in the inside of a substrate by the co-firing method is produced, and at least a part of the electric circuit which is formed on the substrate surface is formed by a thin film, it will become possible to obtain the substrate for light emitting device mounting which has the multilayer electric circuit and was miniaturized more.

Moreover, for example, if the substrate for light emitting device mounting in which the electric circuit was formed in the inside of a substrate by the co-firing method is produced, and at least a part of the electric circuit which is formed on the substrate surface is formed by a thick film metallizing, it becomes possible to obtain the substrate for light emitting device mounting which has the multilayer electric circuit and is miniaturized.

As for the electric circuit formed in the inside of the above-mentioned substrate for light emitting device mounting, it is preferred to use as an electric circuit which usually connected with the conduction via inside a substrate electrically, combined, and was multilayered.

A conductive material which comprises as the main ingredients these metals, alloys, or metal nitride materials can be used not only in a single layer but also in the multilayered state as shown in the above-mentioned formation of the electric circuit by thin film.

The electric circuits which are produced by multilayering the above-mentioned conductive material may be different material each other in the above-mentioned conductive material, and may be the thing formed by multilayering the same material.

The multilayering method of a conductive material can also be suitably performed by heat-treating suitably by plating, a spin coat, an immersion coat, printing, etc.

For example, as an example of the multilayered electric circuit, it may be what is formed by giving nickel plating and gold plating to the metallizing which is obtained by the co-firing and which comprises tungsten, molybdenum, or copper as the main ingredients.

If the surface of metallizing is covered with the material which comprises gold, silver, platinum, nickel, and aluminum as the main ingredients, since connectivity with connection material, such as a wire and a braze material, will improve and resistance against the environment will also improve, it is desirable.

For example, gold plating is usually formed on the surface of the metallizing which comprises tungsten, molybdenum, and copper, etc. as the main ingredients and was formed by the co-firing method, and the above improvement of the connectivity and the resistance against the environment is achieved.

In this invention, if it is the substrate for light emitting device mounting whose electric circuit was formed at least in the inside of the sintered compact which comprises an aluminum nitride as the main ingredients or on the surface of a sintered compact by using a conductive material illustrated above, it is rare that the intensity of the light emitted from the light emitting device which penetrates this substrate and is emitted to the exterior is reduced by this formed electric circuit.

The above-mentioned sintered compact surface whose electric circuit is formed means the surface whose substrate for light emitting device mounting has other than the inside of a sintered compact which comprises an aluminum nitride as the main ingredients, such as the surface on which a light emitting device is mounted, the surface of the opposite side on which a light emitting device is mounted, the side of the cavity space side of the substrate for light emitting device mounting which has cavity space, and the side of the opposite side to the cavity space of the substrate for light emitting device mounting which has cavity space, etc., in the substrate for light emitting device mounting which consists of a sintered compact which comprises an aluminum nitride as the main ingredients and is explained below.

Metallizing for fixing and mounting a light emitting device on a substrate if needed as mentioned above is given to the substrate for light emitting device mounting according to this invention which consists of a sintered compact which comprises an aluminum nitride as the main ingredients.

As mentioned above, as these metallizings what depends on the co-firing method, what depends on the thick film printing method, or what depends on sputter, vapor deposition, and ion-plating, etc., is used suitably.

A light emitting device is fixed and mounted on the sintered compact which comprises an aluminum nitride as the main ingredients by using connection material, such as braze material (low melting point braze material, such as a Pb—Sn system solder alloy, an Au—Si system alloy, an Au—Sn system alloy, an Au—Ge system alloy, a Sn content alloy, an In content alloy, Metal Sn, Metal In, and Pb free solder, or high melting point wax material, such as silver braze, etc. is included), conductive adhesives, or electric insulation adhesives, in the portion in which these metallizings were given.

Since the thermal expansion coefficient is close each other in the substrate for light emitting device mounting according to this invention which consists of a sintered compact which comprises an aluminum nitride as the main ingredients, and the light emitting device which comprises as the main ingredients at least one or more materials selected from a gallium nitride, an indium nitride, and an aluminum nitride, stress generating at the fixed portion is few when this light emitting device is fixed and mounted on a substrate, and it can be used even if it is what kind of connection material other than the above-mentioned connection material.

When a light emitting device is attached on the sintered compact which comprises an aluminum nitride as the main ingredients by using adhesives, such as conductive adhesives or electric insulation adhesives, among the above-mentioned connection material, as for this sintered compact which comprises an aluminum nitride as the main ingredients, metallizing could necessarily be given in a light emitting device loading portion.

In this invention, if it is the substrate for light emitting device mounting whose metallizing was formed in the portion on which the light emitting device is mounted in the sintered compact which comprises an aluminum nitride as the main ingredients by using a conductive material illustrated above at least, it is rare that the intensity of the light emitted from the light emitting device which penetrates a substrate and is emitted to the exterior is reduced by formed metallizing.

As shown according to this invention, it becomes possible that luminescence from a light emitting device penetrates this substrate and is emitted to the substrate surface side opposite to the surface where the light emitting device is mounted by using the sintered compact which comprise an aluminum nitride as the main ingredients, and especially the sintered compact which has optical permeability, as a substrate for light emitting device mounting, it is possible to emit efficiently luminescence from a light emitting device into all the directions of the outside space where a light emitting device is at the center.

Even if it is the substrate which consists of a sintered compact which comprises an aluminum nitride as the main ingredients and which has optical permeability, the light (namely, at least light of the range of 200 nm−800 nm wavelength) from a light emitting device may be reflected about a maximum of 15% on the surface.

When especially the surface smooth nature of a substrate is high, luminescence from a light emitting device is easy to be reflected at an above-mentioned rate. In order to make luminescence from the light emitting device easy to be penetrated strongly to the opposite substrate surface side on which the light emitting device is mounted by controlling the reflectance to luminescence from the light emitting device of the above-mentioned substrate for light emitting device mounting which consists of a sintered compact which comprises an aluminum nitride as the main ingredients and which has optical permeability to not more than 15%, it is preferred to give a reflective prevention function to the surface of this substrate for light emitting device mounting on which the light emitting device is mounted. In this invention, it becomes possible to give a reflective prevention function to the substrate for light emitting device mounting by using the sintered compact which comprises an aluminum nitride as the main ingredients and whose reflective prevention material is formed as a substrate for light emitting device mounting.

That is, for example, if the material whose reflectance is not more than 15% is used as a reflective prevention material into the substrate for light emitting device mounting according to this invention, it will become possible to give a reflective prevention function comparatively easily to the substrate for light emitting device mounting.

The above-mentioned reflectance is to the light of the range of 200 nm-800 nm wavelength at least.

The reflectance to the above-mentioned light of the range of the 200 nm-800 nm wavelength means the reflectance measured by any light of specific wavelength of the range of 200 nm-800 nm wavelength.

If the reflectance within the range of 200 nm-800 nm wavelength of the reflective prevention material formed in the substrate for light emitting device mounting according to this invention is not more than 15%, sufficient reflective prevention function may be generated to luminescence from a light emitting device.

Giving this reflective prevention function can be performed by forming the material whose refractive index is not more than 2.3 and which consists of a transparent material if needed furthermore, such as various glass, various resin, various inorganic crystals, or various inorganic sintered compacts etc., for example, in substrate for light emitting device mounting. Forming such a material on the surface of the substrate for light emitting device mounting on which a light emitting device is being mounted, luminescence from a light emitting device becomes easy to penetrate substrate for light emitting device mounting and to be emitted more strongly to the substrate surface side opposite to the surface where this light emitting device is mounted, it is desirable.

If the material with a larger refractive index than 2.3 is used among the above-mentioned materials, since luminescence from a light emitting device penetrates substrate for light emitting device mounting and the intensity which is emitted to the substrate surface side opposite to the surface where this light emitting device is mounted will tend to become weaker, it is not desirable.

As this invention shows, by forming the above-mentioned material whose refractive index is not more than 2.3 and which consists of a transparent material if needed further in substrate for light emitting device mounting, luminescence from a light emitting device will come to be efficiently emitted from the surface of the substrate opposite to the surface on which this light emitting device is mounted.

This inventor is guessing as follows as the reason.

As for the above-mentioned reflective prevention material, it is preferred that a refractive index is not more than 2.3 and that transparency is high.

If the transparency of a reflective prevention material is low, although the rate that luminescence from the light emitting device is reflected on the substrate surface decreases, since the rate of the light penetrated from this reflective prevention material to a substrate decreases, it is not desirable.

That is, even if it is the substrate which consists of a sintered compact which comprises an aluminum nitride as the main ingredients and which has optical permeability, the light from a light emitting device may be reflected about a maximum of 15% on the surface.

When especially the surface smooth nature of a substrate is high, luminescence from a light emitting device is easy to be reflected at an above-mentioned rate.

Forming the material whose refractive index is not more than 2.3 and which consists of a transparent material if required, since it functions like the reflection of luminescence from the light emitting device which is easy to produce on the surface of substrate for light emitting device mounting is prevented, and the rate of this reflected light becomes not more than 15% (namely, reflectance is not more than 15% to luminescence from a light emitting device), the rate that luminescence from this light emitting device is reflected to the light emitting device mounting surface side decreases, the light which penetrates this substrate for light emitting device mounting increases, more luminescence comes to be emitted from the surface of the substrate opposite to the surface on which this light emitting device is mounted.

As for the refractive index of the material used as the above-mentioned reflective prevention material, it is more preferred that it is not more than 2.1.

As for the refractive index of the material used as the above-mentioned reflective prevention material, it is still more preferred that it is not more than 2.0.

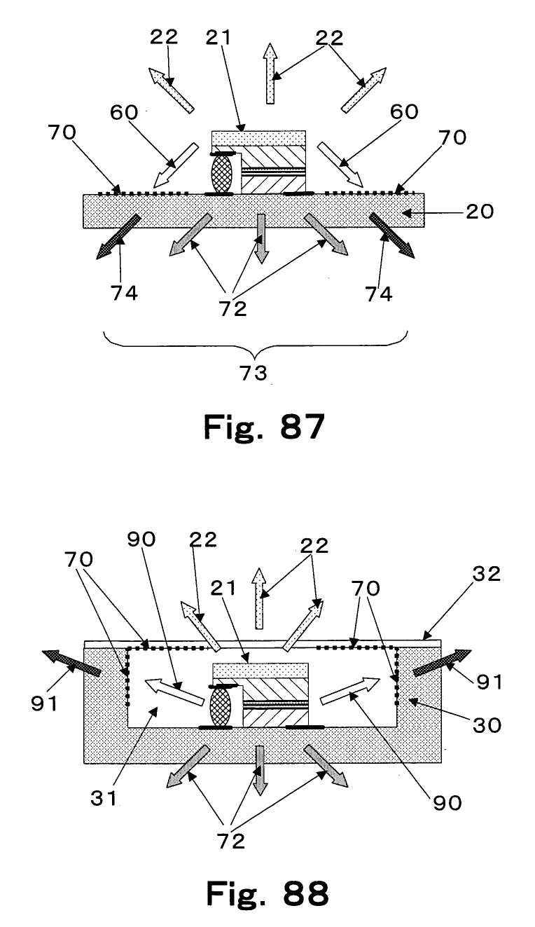

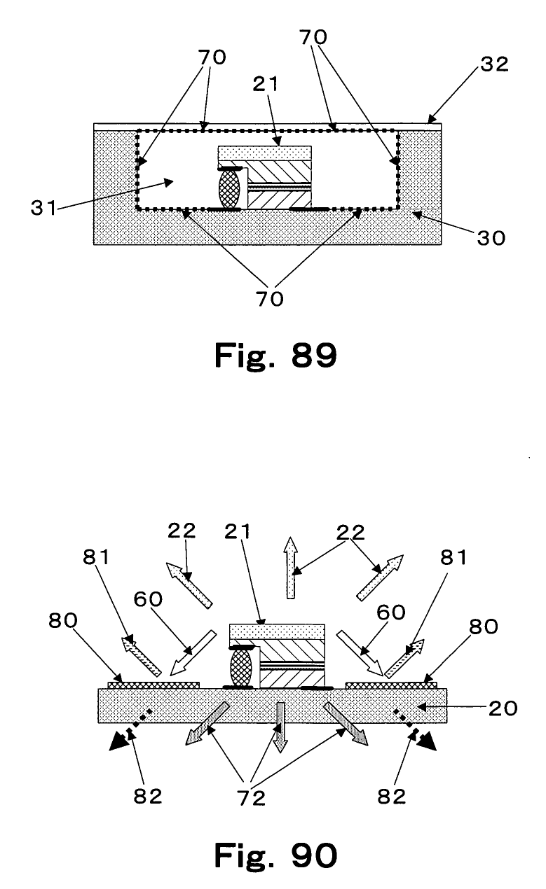

To the substrate for light emitting device mounting according to this invention, this reflective prevention material can form suitably in arbitrary positions according to the purpose, such as the side which forms the cavity space of the substrate for light emitting device mounting which has cavity space as illustrated in FIGS. 88 or FIG. 89, or the lid of the substrate for light emitting device mounting which has cavity space etc. besides the surface on which a light emitting device which was illustrated in FIG. 87 is mounted.

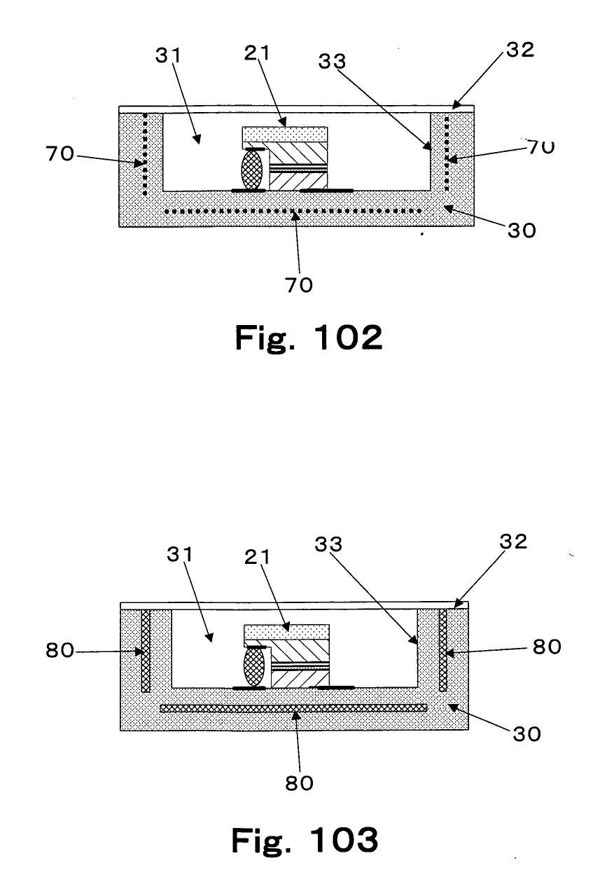

And, it can be formed also in the inside of the substrate which consists of a sintered compact which comprises an aluminum nitride as the main ingredients as illustrated in FIG. 102 if needed.

Usually, as for this reflective prevention material, it is preferred to be formed at the surface of the side on which the light emitting device of this substrate for light emitting device mounting is being mounted.

As a formation position of this reflective prevention material, when substrate for light emitting device mounting is a plate-like, it is preferred to form at the surface of the side on which the light emitting device in this substrate is being mounted.

That is, if substrate for light emitting device mounting has cavity space, it is preferred to be formed at the surface of the side on which the light emitting device is mounted, or the side wall of the cavity space of the side on which the light emitting device is mounted, or the lid surface of the side on which the light emitting device is mounted.

In the substrate for light emitting device mounting according to this invention, luminescence from a light emitting device is more strongly emitted to the substrate exterior from the portion in which the above-mentioned reflective prevention material was formed.

In the above-mentioned reflective prevention material, the meaning of “being transparent” means that optical transmissivity is at least not less than 30%.

This transparent reflective prevention material usually consists of the material in which light penetrates linearly like glass, resin, or an inorganic crystal, or the material in which light is penetrated as a scattered light by the polycrystal particle inside a sintered compact like various inorganic sintered compact material, etc.

Although the transparency of such a reflective prevention material changes by the thickness formed in substrate for light emitting device mounting, even if it is what kind of thickness, that optical transmissivity is not less than 30% in the state where it is formed is desirable when functioning as a reflective prevention material.

For example, if optical transmissivity is smaller than 30% in the state of this thickness even if it is the thin thing whose thickness which is being formed in substrate for light emitting device mounting is about 10 nm, it is not desirable as a reflective prevention material according to this invention.

Conversely, if optical transmissivity is not less than 30% in the state of this thickness even if it is the comparatively thick thing whose thickness which is being formed in substrate for light emitting device mounting is about 1 mm, it is desirable as a reflective prevention material according to this invention.

As for the optical transmissivity of the above-mentioned reflective prevention material, it is more preferred that it is not less than 50%.

As-for the optical transmissivity of the above-mentioned reflective prevention material, it is still more preferred that it is not less than 80%.

The above-mentioned reflectance, refractive index, and optical transmissivity of the reflective prevention material in this invention are to the light of the range of 200 nm-800 nm wavelength at least.

Thus, in this invention, as a reflective prevention material it is preferred to use the above material whose refractive index is not more than 2.3 and which is transparent if it requires, and can become into not more than 15% about reflectance if it requires further.

The sectional view of the substrate for light emitting device mounting according to this invention which used the sintered compact which comprises an aluminum nitride as the main ingredients and in which the reflective prevention material is formed is illustrated in FIG. 87, FIG. 88, FIG. 89, and FIG. 102.

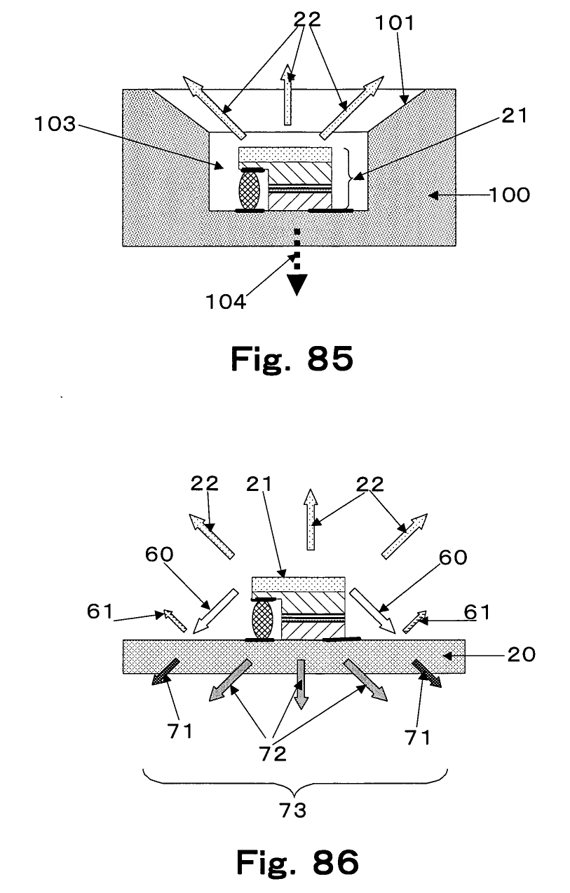

FIG. 86 is a sectional view of the substrate for light emitting device mounting for making the effect of a reflective prevention material easier to explain, and the substrate for light emitting device mounting 20 shown in FIG. 86 shows the state before a reflective prevention material is formed.

The reflective prevention material 70 is formed on the substrate for light emitting device mounting 20 which consists of a sintered compact which comprises an aluminum nitride as the main ingredients and is shown in FIG. 87 and in the substrate for light emitting device mounting 30 which consists of a sintered compact which comprises an aluminum nitride as the main ingredients and is shown in FIG. 88, FIG. 89, and FIG. 102.

In FIG. 86, luminescence from a light emitting device 21 is emitted to the substrate exterior as a emitted light 22 to the surface side on which this light emitting device is mounted and as a emitted light 73 to the surface of the opposite surface side on which this light emitting device is mounted. In FIG. 86, the part of the light 60 which is being irradiated to the substrate surface on which the light emitting device 21 is mounted is reflected by this substrate surface, and it is easy to be emitted as reflected light 61 into the substrate exterior of the substrate surface side on which a light emitting device was mounted.

Therefore, the light 60 which is being irradiated to the substrate surface on which the light emitting device 21 is mounted penetrates a substrate, then the light 73 emitted to the substrate exterior from the substrate surface side opposite to the substrate surface on which the light emitting device is mounted will tend to become weak.

When the reflective prevention material is not formed, the intensity of the reflected light 61 from the light 60 irradiated to the surface of the substrate-for-light-emitting-device-mounting which consists of a sintered compact which comprises an aluminum nitride as the main ingredients is about a maximum of 15% to this light 60.

The emitted light 73 in the above-mentioned FIG. 86 is the thing in which the light 71 which penetrates the substrate portion before forming the reflective prevention material shown in following FIG. 87, FIG. 88, FIG. 89, and FIG. 102 and is emitted to the substrate exterior, and the light 72 which penetrates the substrate of the portion not forming the reflective prevention material and is emitted to the substrate exterior are totaled.

In FIG. 87, the reflective prevention material 70 is formed on the substrate for light emitting device mounting 20 which consists of a sintered compact which comprises an aluminum nitride as the main ingredients.

This reflective prevention material 70 is formed on the substrate surface on which the light emitting device 21 is mounted.

In FIG. 87, since reflection in the substrate surface is controlled, the light 60 which is being irradiated to the substrate surface on which a light emitting device is mounted is hardly reflected and penetrates a substrate, and it is emitted to the substrate exterior from the substrate surface side opposite to the substrate surface on which a light emitting device is mounted, so the intensity of the emitted light 74 from a substrate portion on which the reflective prevention material is formed becomes large if compared with the emitted light 71 of the state before a reflective prevention material is formed as shown in FIG. 86.

Therefore, the intensity of all the emitted light 73 emitted to the substrate exterior from the substrate surface side opposite to the substrate surface on which the light emitting device 21 is mounted becomes also large.

The emitted light 73 in the above-mentioned FIG. 87 is the thing in which the light 74 which penetrates the substrate of the portion forming the reflective prevention material shown in FIG. 87 and is emitted to the substrate exterior, and the light 72 which penetrates the substrate of the portion not forming a reflective prevention material and is emitted to the substrate exterior are totaled.

Thus, in FIG. 87, since reflection in the substrate surface is controlled as for the light 60 irradiated to the substrate surface from a light emitting device when the reflective prevention material 70 is formed, it penetrates substrate for light emitting device mounting 20 efficiently, and is emitted to the substrate exterior as a strong light 74 from the surface of the opposite side on which the light emitting device is mounted.

As substrate for light emitting device mounting on which the reflective prevention material is formed, not only that whose reflective prevention material is formed on the substrate surface which separated a few from the light emitting device 21 as drawn on FIG. 87 but also what is being formed on the neighboring substrate surface of a light emitting device 21 or the substrate surface of a light emitting device mounting portion is included in this invention.

That is, a reflective prevention material can be formed in any positions on the surface of substrate for light emitting device mounting, and the effect of the formed reflective prevention material is not influenced by the formation position of the substrate surface but has the same effect.

If the rate of an area whose reflective prevention material 70 is formed is high to a substrate area, the emitted light 73 from the substrate surface side opposite to the substrate surface on which a light emitting device is mounted is easy to increase.

FIG. 88 shows the example in which the reflective prevention material is being formed in the substrate for light emitting device mounting in which a cavity space (cavity) is formed.

In FIG. 88, the reflective prevention material 70 is being formed on the side wall which forms the cavity space of the substrate for light emitting device mounting 30 which consists of a sintered compact which comprises an aluminum nitride as the main ingredients and has cavity space 31.

In FIG. 88, this reflective prevention material 70 is being formed on a part of the surface of the side of light emitting device mounting of a lid 32.

Light 90 irradiated from a light emitting device 21 towards the side wall portion forming a cavity space and the lid penetrates a substrate, and is emitted to the substrate exterior as a light 91, without almost being reflected by the reflective prevention material 70 which is being formed on the side wall and the lid.

As shown in FIG. 88, the light 91 emitted to the substrate exterior from the portion in which the reflective prevention material is being formed tends to become what has more large intensity if compared before a reflective prevention material is formed.

FIG. 89 shows the example in which the reflective prevention material is formed on the substrate for light emitting device mounting which has cavity space (cavity).

The reflective prevention material 70 is being formed on the whole side wall which forms the cavity space and the surface on which the light emitting device of the substrate for light emitting device mounting 30 which consists of a sintered compact which comprises an aluminum nitride as the main ingredients and has cavity space 31 is mounted.

The reflective prevention material 70 is formed also on the whole surface of the side of light emitting device mounting of a lid 32.

In this invention, as the above-mentioned substrate for light emitting device mounting in which the reflective prevention material is formed, there are not only a plate-like thing which is shown in FIG. 87 but also that whose conduction via is being formed in the plate-like thing as illustrated in FIG. 75 and FIG. 81, and not only what has only cavity space (cavity) as illustrated in FIG. 88 and FIG. 89 but also that whose conduction via is formed in the thing of form which has cavity space as illustrated in FIG. 76, FIG. 82, FIG. 83, and FIG. 84, etc.

As for a reflective prevention material, in the substrate for these light emitting devices, it is usually preferred to be formed on the surface of the side on which the light emitting device of this substrate for light emitting device mounting is mounted.

In the lid used for seal of the substrate for light emitting device mounting which has cavity space etc., when a reflective prevention material, a sealing agent, etc. react and deteriorate in heating at the time of seal, this reflective material may be formed on the surface of the side of opposite on which a light emitting device is mounted.

As the above reflective prevention material which is transparent and consists of the material with a refractive index not more than 2.3, for example, it is preferred to use glass material, such as quartz glass, high silica glass, soda lime glass, lead soda glass, potash glass, lead potash glass, aluminosilicate glass, borosilicate glass, nonalkali glass, chalcogenide glass, telluride glass, orthophosphate glass, lanthanum glass, lithium content glass, barium content glass, zinc content glass, fluoride content glass, lead content glass, nitrogen content glass, germanium content glass, crown glass, boro crown glass, dense barium crown glass, a rare earth element, or niobium, the crown glass containing tantalum, flint glass, light flint glass, dense flint glass, flint glass containing a rare earth element or niobium, tantalum, solder glass, optical glass, and various crystallized glass, etc.

Such glass material can use the thing of various forms, such as the shape of a thin film, the shape of a thick film, or the shape of a board.

As the above-mentioned reflective prevention material, for example, it is preferred to use the resin material which comprises as the main ingredients at least one or more materials selected from epoxy resin, silicone resin, polyimide resin, phenol resin, bismaleimide triazine resin (BT resin), unsaturated polyester, fluoroplastic, such as PTFE, and PFA, FEP or PVdF, acrylic resin, methacrylic resin, poly methyl methacrylate resin (PMMA), styrene acrylonitrile copolymerization resin (SAN), allyl diglycolic carbonate resin (ADC), polyurethane resin, thiourethane resin, diallylphthalate resin (DAP), polystyrene, polyether ether ketone (PEEK), polyethylenenaphthalate (PEN), thermoplastic polyimide resin, polyamide imide (PAI), saturation polyester, polyethylene terephthalate (PET), a polybutylene terephthalate (PBT), polycarbonate (PC), polyamide, polyphenylene sulfide (PPS), polyphenylene ether (PPE), polyphenylene oxide (PPO), polyether imide (PEI), polyether sulfone (PES), polymethyl pentene (PMP), polyethylene (PE), polypropylene (PP), ethylene vinyl alcohol copolymer, polysulfone, polyalylate, diallyl phthalate, polyacetal, etc.

Such resin material can use the thing of various forms, such as the shape of a thin film, the shape of a thick film, or the shape of a board.

As for the above-mentioned reflective prevention material, for example, it is preferred to use as the thin film, a thick film, a single crystal or a polycrystalline substance, a sintered compact etc., which consists of inorganic materials, such as a metal oxide, a metal nitride, and a metal carbide, which comprise as the main ingredients at least one or more materials selected from beryllium (Be), magnesium (Mg), calcium (Ca), strontium (Sr), barium (Ba), scandium (Sc), yttrium (Y), lanthanum (La), cerium (Ce), praseodymium (Pr), neodymium (Nd), samarium (Sm), europium (Eu), gadolinium (Gd), dysprosium (Dy), holmium (Ho), erbium (Er), ytterbium (Yb), lutetium (Lu), zirconium (Zr), hafnium (Hf), niobium (Nb), tantalum (Ta), molybdenum (Mo), tungsten (W), zinc (Zn), boron (B), aluminum (Al), gallium (Ga), indium (In), silicon (Si), germanium (Ge), tin (Sn), and antimony (Sb).

As for these inorganic materials, such as metal oxide, a metal nitride, and metal carbide, not only what is the state of crystalline material but also what is an amorphous state can be used.

These inorganic materials, such as metal oxide, a metal nitride, and metal carbide, can use the thing of various forms, such as the shape of a thin film, the shape of a thick film, or the shape of a board.

As the formation method of such a reflective prevention material to the substrate for light emitting device mounting, there are methods, like how to join what made the various above-mentioned glass material, resin material, and inorganic material the shape of a board or the shape of foil to this substrate for light emitting device mounting by using adhesives, solder, braze material, etc. or by being stuck by pressure, for example, how to join what made these various glass material, resin material, and inorganic material the shape of a thin film by sputter, vapor deposition, ion-plating, plating, CVD, and a spin coat, etc. to this substrate for light emitting device mounting, or forming by performing the co-firing of the powder paste and sol-gel paste which comprise as the main ingredients these various glass materials and inorganic materials with the sintered compact which comprises an aluminum nitride as the main ingredients, or how to join to this substrate for light emitting device mounting by printing later or pasting up the powder paste and sol gel paste etc. which comprise as the main ingredients these various glass materials, resin materials, and inorganic materials to the already produced sintered compact which comprises an aluminum nitride as the main ingredients, they can be selected suitably.

Usually, it is preferred to use coats, such as alumina, silica, and magnesia, as the above-mentioned reflective prevention material.

In the above-mentioned reflective prevention material, the self-oxidization coat of the sintered compact which comprises an aluminum nitride as the main ingredients can also be used suitably.

This self-oxidization coat can lower the reflectance of the sintered compact which comprises an aluminum nitride as the main ingredients and is a base material to not more than 15%.

This self-oxidization coat can usually be easily formed by heating the sintered compact which comprises an aluminum nitride as the main ingredients in the oxidization atmosphere in the high temperature atmosphere etc. of 700 degrees C.-1500 degrees C.

This self-oxidization coat consists of an aluminum oxide, and the adhesion nature with the sintered compact which comprises an aluminum nitride as the main ingredients and is a base material is high.

Since it is an aluminum oxide and the permeability to the light to the wavelength domain of ultraviolet rays is also high, it is desirable.

As for thickness, what is not more than 10 μm is obtained easily.

To the substrate for light emitting device mounting according to this invention, this reflective prevention material can be formed in arbitrary positions according to the purpose, such as the surface on which the light emitting device is mounted, or the side which forms the cavity space of the substrate for light emitting device mounting which has cavity space, or the lid of the substrate for light emitting device mounting which has cavity space etc. as illustrated in FIG. 87, FIG. 88, and FIG. 89.

In this invention, since the sintered compact which comprises an aluminum nitride as the main ingredients and which has optical permeability can be used as a substrate for light emitting device mounting, even if this reflective prevention material is in the inside of the sintered compact which comprises an aluminum nitride as the main ingredients, it can generate the reflective prevention function.

Using the substrate which has optical permeability, the light from a light emitting device arrives even at the inside of the substrate in which the reflective prevention material was formed, and the reflective prevention function by this reflective prevention material can be generated.

As the formation method of the reflective prevention material to the inside of the substrate for light emitting device mounting, there are methods, like how to join what made the above-mentioned various glass material, resin material, and inorganic material the shape of a board or the shape of foil by using adhesives, solder, braze material, etc. or by being stuck by pressure by sandwiching with this substrate for light emitting device mounting, for example, how to join these substrates for light emitting device mounting each other after what made these various glass material, resin material, and inorganic material the shape of a thin film on sputter, vapor deposition, ion-plating, plating, CVD, a spin coat, etc. is formed on two or more substrates for light emitting device mounting, or the method of forming by performing the co-firing of the powder paste and sol-gel paste which comprise as the main ingredients these various glass materials and inorganic materials with-the sintered compact which comprises an aluminum nitride as the main ingredients, or how to join these substrates for light emitting device mounting each other after forming the powder paste and sol gel paste etc. which comprise as the main ingredients these various glass materials, resin materials, and inorganic materials on two or more substrates for light emitting device mounting by printing later or pasting up to the already produced sintered compact which comprises an aluminum nitride as the main ingredients, they can be selected suitably.

In FIG. 102, the example whose reflective prevention material formed in the inside of the sintered compact which comprises an aluminum nitride as the main ingredients is shown.

In FIG. 102, the reflective prevention material 70 is formed in the inside of the portion in which the light emitting device of the substrate for light emitting device mounting 30 which has cavity space 31 and consists of a sintered compact which comprises an aluminum nitride as the main ingredients is mounted, and the inside of the side wall 33 which forms the cavity space. Thus, this reflective prevention material can be formed in one of the insides or the surfaces of a sintered compact which comprise an aluminum nitride as the main ingredients, and can also be formed simultaneously in both of the inside and surface of the sintered compact which comprises an aluminum nitride as the main ingredients.

As mentioned above, in this invention, by using the sintered compact which comprises an aluminum nitride as the main ingredients and which has optical permeability as a substrate for light emitting device mounting and by forming a reflective prevention material in this substrate for light emitting device mounting, luminescence from a light emitting device is emitted not only to the substrate surface side on which this light emitting device was mounted but also to the substrate surface side opposite to the surface on which this light emitting device was mounted, and it became possible to emit efficiently to all the directions of the circumference space of a light emitting device.

On the other hand, by adding a optical reflective function to the substrate for light emitting device mounting using the sintered compact according to this invention which comprises an aluminum nitride as the main ingredients and forms the reflective material as a substrate for light emitting device mounting, it is also possible that the luminescence from a light emitting device is emitted strongly to the specific direction.

By reflecting a part or all of luminescence from a light emitting device by giving a reflective function to the substrate for light emitting device mounting, it is possible to promote or control that whose luminescence from this light emitting device penetrates the substrate for light emitting device mounting which consists of a sintered compact which comprises an aluminum nitride as the main ingredients and which has optical permeability, and is emitted to the substrate surface side opposite to the surface on which this light emitting device was mounted.

That is, compared with the case where the reflective function is not given to the substrate for light emitting device mounting according to this invention, stronger luminescence can also be emitted from the surface by the side of light emitting device mounting of substrate for light emitting device mounting, or luminescence can be emitted only from the surface by the side of light emitting device mounting of substrate for light emitting device mounting.

On the contrary, compared with the case where the reflective function is not given to the substrate for light emitting device mounting according to this invention, stronger luminescence can also be emitted from the surface of the opposite side on which the light emitting device of substrate for light emitting device mounting is being mounted, or luminescence can be emitted only from the surface of the opposite side on which the light emitting device of substrate for light emitting device mounting is being mounted.

In the substrate which consists of a sintered compact which comprises an aluminum nitride as the main ingredients and which has optical permeability, the light from a light emitting device (namely, at least light of the range of 200 nm-800 nm wavelength) is reflected only about a maximum of 15% on the surface in many cases.

In order to raise a reflective function as a reflective material formed in the substrate for light emitting device mounting according to this invention, it is preferred to use what has reflectance not less than 15% at least to luminescence from a light emitting device.

It is more preferred to use the material whose reflectance to luminescence from a light emitting device is not less than 50%.

It is still more preferred to use the material whose reflectance to luminescence from a light emitting device is not less than 70%.

It is most preferred to use the material whose reflectance to luminescence from a light emitting device is not less than 80%.

The reflectance to the above-mentioned light from the light emitting device is a reflectance to the light of at least the range of 200 nm-800 nm wavelength.

The reflectance to the above-mentioned light of the range of the 200 nm-800 nm wavelength means the reflectance measured by the light with the wavelength of either specification of the range of 200 nm-800 nm wavelength.

Unless it refused especially in this invention, the reflectance to the light with a wavelength 605 nm was usually used.

If the reflectance of the reflective material formed in the substrate for light emitting device mounting according to this invention is in the above range, sufficient reflective function may be generated to luminescence from a light emitting device.

Thus, by adding a light reflex function to the substrate for light emitting device mounting in this invention, it becomes possible to control the intensity of luminescence from this light emitting device to all the space directions of the circumference of a light emitting device comparatively easily.

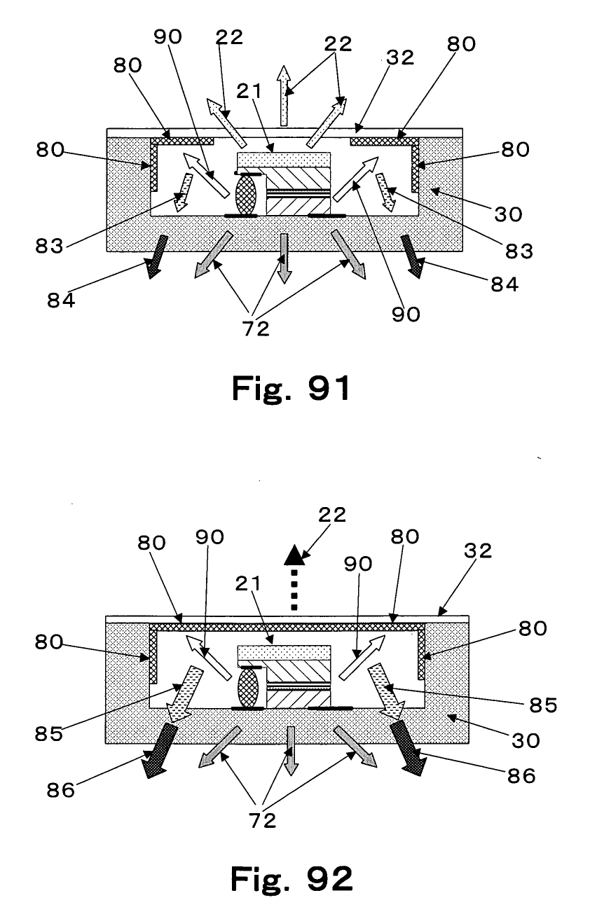

In this invention, FIG. 90, FIG. 91, FIG. 92, and FIG. 103 are shown as the example which used the sintered compact which comprises an aluminum nitride as the main ingredients and which forms the above-mentioned reflective material as a substrate for light emitting device mounting.

FIG. 90, FIG. 91, and FIG. 92 are sectional views showing the substrate for light emitting device mounting according to this invention in which the reflective material is formed.

As the substrate for light emitting device mounting according to this invention in which the reflective material is formed, there are not only the plate-like thing shown in FIG. 90, or what has the cavity space (cavity) shown in FIGS. 91 and FIG. 92 but also the thing in which the conduction via 40 is formed in the plate-like thing as illustrated in FIG. 75 and FIG. 81, and the thing in which conduction via 40 is formed in what is the form which has cavity space as illustrated in FIG. 76, FIG. 82, FIG. 83, and FIG. 84, etc., for example.

To the substrate for light emitting device mounting according to this invention, this reflective material can be formed suitably in arbitrary positions according to the purpose, such as the substrate surface on which the light emitting device is mounted as illustrated in FIG. 90, FIG. 91, and FIG. 92, or the side which forms the cavity space of the substrate for light emitting device mounting which has cavity space (cavity), or the lid of the substrate for light emitting device mounting which has cavity space (cavity), etc.

A reflective material can be formed also in the inside of the substrate for light emitting device mounting which consists of a sintered compact which comprises an aluminum nitride as the main ingredients if needed.

In FIG. 103, the example in which a reflective material was formed in the inside of the substrate for light emitting device mounting which consists of a sintered compact which comprises an aluminum nitride as the main ingredients is shown.

Usually, as for this reflective material, it is preferred to be formed on the substrate surface in which the light emitting device of this substrate for light emitting device mounting is mounted.

As a formation position of this reflective material, it is preferred to be formed on the substrate surface of the side on which the light emitting device of this substrate is being mounted when substrate for light emitting device mounting is a plate-like, if substrate for light emitting device mounting has cavity space, it is preferred to be formed on the substrate surface of the side on which the light emitting device is being mounted, or the side wall which forms the cavity space of the side on which a light emitting device is being mounted, or the surface of the side on which the light emitting device of a lid is being mounted.

FIG. 90 is a sectional view showing the example of the substrate for light emitting device mounting on which the reflective material was formed.

In order to clarify more the effect of the reflective material being formed, it explains comparing by using the above-mentioned FIG. 86 again as a substrate for light emitting device mounting before a reflective material is formed.

The substrate for light emitting device mounting 20 shown in FIG. 86 shows the state before a reflective material is formed.

That is, in FIG. 86, luminescence from a light emitting device 21 is emitted to the substrate exterior, as a emitted light 22 to the surface side on which this light emitting device is being mounted, and as a emitted light 73 to the surface of the side opposite to the surface on which this light emitting device is being mounted.

In FIG. 86, as for the light 60 which is being irradiated to the substrate surface on which the light emitting device 21 is being mounted, the part is reflected by this substrate surface, and it is easy to be emitted as reflected light 61 to the substrate exterior of the side of a substrate surface on which a light emitting device was mounted.

The great portion of light 60 which is being irradiated to the substrate surface penetrates a substrate and is easy to be emitted to the substrate exterior as a light 71 from the substrate surface side opposite to the substrate surface on which a light emitting device is mounted.

When the reflective material is not formed, the intensity of the reflected light 61 from the light 60 irradiated to the surface of the substrate-for-light-emitting-device-mounting which consists of a sintered compact which comprises an aluminum nitride as the main ingredients is about a maximum of 15% to this light 60.

On the other hand, if the reflective material 80 is formed on the substrate for light emitting device mounting 20 as shown in FIG. 90, the light 60 irradiated to the surface on which the light emitting device is mounted among luminescence from a light emitting device 21 becomes reflected light 81 and will be easy to be emitted to the substrate exterior of the surface side on which the light emitting device is mounted.

The intensity of this reflected light 81 is high compared with the intensity of the reflected light 61 (shown in FIG. 86) in case the reflective material is not formed.

Therefore, if the reflective material 80 is formed on the substrate for light emitting device mounting, luminescence from a light emitting device 21 will be emitted more from the surface side on which the light emitting device 21 is mounted compared with the case where the reflective material is not formed.

By forming the reflective material 80, as shown in FIG. 90, the light 60 irradiated to the surface on which the light emitting device is mounted among luminescence from a light emitting device 21 is reflected to the surface side on which the light emitting device 21 is mounted.

Therefore, by forming the reflective material 80, the light 82 which is emitted from the opposite substrate surface side on which the light emitting device is mounted by penetrating the substrate for light emitting device mounting 20 is emitted to the substrate exterior as a weak light, or the case where it is no longer substantially emitted to the substrate exterior arises.

As substrate for light emitting device mounting on which the reflective material is being formed, not only that whose reflective material 80 is formed on the substrate surface which separated a few from the light emitting device 21 as drawn in FIG. 90 but also what is being formed on the neighboring substrate surface of a light emitting device 21 or the substrate surface of a light emitting device mounting portion is included in this invention.

That is, a reflective material can be formed in any positions on the surface of substrate for light emitting device mounting, and the effect of the formed reflective material is not influenced in the formation position of a substrate surface but has the same effect.

As fot the reflective material 80, if the rate of a formed area is high to a substrate area, reflected light 81 increases and it becomes easier to increase the light emitted from the substrate surface side on which a light emitting device is mounted.

In FIG. 91, the reflective material 80 is formed in the substrate for light emitting device mounting 30 which has cavity space (cavity).

The reflective material 80 is formed on the side wall which forms cavity space, and the surface side on which the light emitting device of a lid 32 is mounted.

This reflective material 80 is not formed on the substrate surface on which the light emitting device is mounted.

In FIG. 91, the reflective material 80 is formed on the side wall which forms the cavity space of the substrate for light emitting device mounting 30 which has cavity space.

In FIG. 91, this reflective material 80 is formed on a part of the surface of the light emitting device mounting side of a lid 32.

Luminescence 90 from a light emitting device 21 which is irradiated towards the side wall portion and lid on which this reflective material 80 is formed is reflected by a reflective material, the intensity of the light which is emitted to the substrate exterior from the portion of the side wall and lid on which this reflective material is formed tends to become small.

This luminescence 90 becomes into reflected light 83 in the inside of a cavity space, penetrates the substrate portion in which a reflective material is not formed, and is emitted to the substrate exterior as the emitted light 84.

As shown in FIG. 91, when the reflective material is formed, the light 84 which is emitted to the substrate exterior from a light emitting device mounting side tends to become what has more large intensity compared with the case where the reflective material is not formed.

FIG. 92 illustrates a situation whose reflective material is being formed on the whole surface of the light emitting device loading side of the lid which is being joined to the substrate for light emitting device mounting which has cavity space.

In FIG. 92, the reflective material 80 is formed on the whole surface of the light emitting device mounting side of a lid 32.

Although the reflective material 80 which is being formed in the lid is being formed in a part of this lid in the substrate for light emitting device mounting illustrated in FIG. 91, in the substrate for light emitting device mounting illustrated in FIG. 92, the reflective material 80 is formed all over the lid.

Therefore, luminescence 90 from a light emitting device 21 which is irradiated towards the side wall portion and lid on which the reflective material 80 is formed is reflected by a reflective material, it is getting hard to be emitted to the substrate exterior from this side wall and lid.

In FIG. 92, the intensity of the light which is emitted to the substrate exterior from the portion of the side wall and lid in which the reflective material is formed tends to become small.

Therefore, in FIG. 92, the luminescence 90 which is irradiated towards the side wall portion and lid on which the reflective material 80 is formed from the light emitting device 21 turns into the reflected light 85 with intensity higher than the reflected light 83 inside the cavity space shown in FIG. 91, penetrates substrate for light emitting device mounting, turns into the light 86 with more high intensity, and is emitted to the substrate exterior.

The light 86 which is emitted to the substrate exterior from a light emitting device mounting side when the reflective material is formed all over the lid, as shown in FIG. 92 tends to become what has more large intensity compared with that whose reflective material is formed in a part of the lid as shown in FIG. 91.

In the substrate for light emitting device mounting shown in FIG. 92, luminescence from a light emitting device 21 is almost reflected by a reflective material, and it becomes also possible to emit only from the substrate surface on which the light emitting device is mounted rather than to be emitted to the substrate exterior from the side wall of substrate for light emitting device mounting and the lid 32 substantially.

In addition, the light emitted from a light emitting device is reflected by this reflective material by forming a reflective material, direct emitting to the substrate exterior can also be made as a strong light which does not penetrate the substrate which consists of a sintered compact which comprises an aluminum nitride as the main ingredients.

In this invention, even if the sintered compact which comprises an aluminum nitride as the main ingredients and forms a substrate has high optical transmissivity, luminescence from a light emitting device can be emitted to the substrate exterior, without making a substrate penetrate substantially.

That is, in this invention, the luminescence direction from a light emitting device can be more precisely controlled by forming a reflective material in the sintered compact which comprises an aluminum nitride as the main ingredients.

The above-mentioned reflective function can be easily given to the substrate for light emitting device mounting according to this invention.

For example, this reflective function is obtained by usually forming suitably various metal material or alloy material in the substrate for light emitting device mounting which consists of a sintered compact of optical permeability which comprises an aluminum nitride as the main ingredients as a reflective material.

The reflective material which comprises various above-mentioned metal material or alloy material can reflect luminescence from a light emitting device in low loss.

As such a metal material or alloy material, what comprises as the main ingredients one or more elements among Be, Mg, Sc, Y, a rare earth metal, Ti, Zr, Hf, V, Nb, Ta, Cr, Mo, W, Mn, Re, Fe, Co, Ni, Ru, Rh, Pd, Os, Ir, Pt, Cu, Ag, Au, Zn, B, Al, Ga, In, Si, Ge, Sn, Pb, Sb, Bi etc. can be used suitably.

The reflectance of such metal or alloy to the light with a wavelength 605 nm is usually not less than 15%, and can be enough used as a reflective material.

Such metal material or alloy material can be used not only in the single layer but also in the multilayered state.

The reflective material which multilayered metal material or alloy material and was produced may be different material, and may be what multilayered the same material and was formed.

The multilayering method of the above-mentioned material can also use methods, such as plating, a spin coat, an immersion coat, and printing etc., and it can perform heat-treating suitably after multilayering if it requires.

For example, as a multilayered material it may be what is formed by giving nickel plating and gold plating to the metallizing which is by the co-firing and which comprises tungsten, molybdenum, or copper as the main ingredients.

As for such metal material and alloy material, not only what is the state of crystalline material but also what is an amorphous state can be used.

In such metal material or alloy material, as for the metal or the alloy which comprises as the main ingredients one or more elements selected from Cu, Ag, Au, Al, Mg, Zn, Mo, W, Mn, Fe, Co, Ni, Rh, Pd, Os, Ir, and Pt, since it is easy to obtain what is as high as not less than 50% of the reflectance to the light with a wavelength 605 nm, and loss is small, it is desirable. In the above-mentioned metal material or alloy material, as for the metal or the alloy which comprises as the main ingredients one or more elements selected from Cu, Ag, Au, Al, Mg, Zn, Fe, Co, Ni, Rh, Pd, Os, Ir, and Pt, since the reflectance to the light with a wavelength 605 nm is as higher as not less than 70% and loss is still smaller, it is desirable. In these metals or alloys, as for alloys with Cu, Ag, Au, W, and Mo, such as copper/tungsten, copper/molybdenum, silver/tungsten, silver/molybdenum, gold/tungsten, and gold/molybdenum, since the reflectance to the light with a wavelength 605 nm tends to obtain what has not less than 50%, further according to composition, what has as high reflectance as not less than 70% is obtained, it can use suitably as a reflective material.

Among the above-illustrated 14 kinds of the metal or alloy which are reflectance not less than 70%, as for the metal or alloy which comprise as the main ingredients at least one or more materials which are selected from Rh, Pd, Os, Ir, and Pt etc. of the platinum group, since what has reflectance not less than 80% is obtained according to production conditions, it is desirable.

In addition, among these metals or alloy materials of reflectance not less than 70%, as for the metal or alloy which comprise Cu, Ag, Au, and Al as the main ingredients, it is easy to obtain the thing whose reflectance is as high as not less than 80% to the light with 605 nm wavelength, so loss is the smallest, it is desirable.

Thus, the various above-mentioned metal or alloy material has a good reflective function to luminescence from a light emitting device, when it is used as a reflective material which forms in the substrate for light emitting device mounting according to this invention.

In this invention, when the above various metal material or alloy material which is used suitably as a reflective material is a material homogeneous as a conductive material which forms the above-mentioned electric circuit, a part of the above-mentioned electric circuit can be used as a reflective material.

As for the method for forming the reflective material which consists of the above various metal material or alloy material in the substrate for light emitting device mounting, there are methods, like how to join the board or foil of this metal material or alloy material by using adhesives, solder, braze material, etc. to this substrate for light emitting device mounting, or being stuck by pressure etc., how to join what made this metal material or alloy material the shape of a thin film on sputter, vapor deposition, ion-plating, plating, CVD, the immersing method, the spin coat, etc. to this substrate for light emitting device mounting, forming by performing the co-firing of the powder paste which comprises as the main ingredients this metal material or alloy material with the sintered compact which comprises an aluminum nitride as the main ingredients, or how to join to this substrate for light emitting device mounting as a thick film by printing later to the already produced sintered compact which comprises an aluminum nitride as the main ingredients, etc., it can select suitably.

Giving the above-mentioned reflective function to the substrate for light emitting device mounting according to this invention can also be performed comparatively easily by using the material of refractive index not less than 2.1.

That is, reflectance improves by leaps and bounds by forming the material of refractive index not less than 2.1 in the sintered compact which comprises an aluminum nitride as the main ingredients.

As for the luminescence from a light emitting device (namely, at least light of the range of 200 nm-800 nm wavelength), it was found out that reflectance improves by leaps and bounds in the sintered compact in which the material of a refractive index not less than 2.1 used as the above-mentioned reflective material was formed and comprises an aluminum nitride as the main ingredients.

Although the reflectance of a sintered compact which comprises an aluminum nitride as the main ingredients is about a maximum of 15% itself to the light of the range of 200 nm-800 nm wavelength and it is usually 10%-15%, it increases by leaps and bounds by forming the material of refractive index not less than 2.1.

For example, by sputtering, etc., in what formed the coat which comprises as the main ingredients a TiO₂ whose refractive index is 2.4-2.8 to the light of the range of 200 nm-800 nm wavelength, onto the sintered compact which comprises an aluminum nitride as the main ingredients, reflectance improves to not less than 80%.

Although the reflectance of TiO₂ which is a coat is about a maximum of 20% itself to the light of the range of 200 nm-800 nm wavelength and it is usually 10%-20%, the fast improvement in the reflectance which is not seen alone respectively is attained by forming in the sintered compact which comprises an aluminum nitride as the main ingredients.

It is guessed that because a total reflection probably arises at the interface of the material of refractive index not less than 2.1 and the aluminum nitride, the fast improvement in reflectance is brought.

As for luminescence from a light emitting device, by using the material of refractive index not less than 2.1 which is easy to produce a total reflection as a reflective material, the direction of this luminescence is easily controllable.

Since it seems that the reflective function which used the material of such refractive index not less than 2.1 generates by a total reflection, direction control is carried out without losing most luminescence from a light emitting device, it can be emitted to the substrate exterior, it is desirable.

Since the reflectance of the aluminum nitride sintered compact in which the material of refractive index not less than 2.1 was formed becomes easy to improve into not less than 30%, it is preferred.

Since reflectance will tend to lower when it is formed in the sintered compact which comprises an aluminum nitride as the main ingredients, if the refractive index of the material which is used as a reflective material is smaller than 2.1, it is not desirable.

It is surmised that it is because a total reflection arises at the interface between the above-mentioned reflective material and the sintered compact which comprises an aluminum nitride as the main ingredients, when the refractive index of this reflective material is not less than 2.1.

As for the refractive index of the above-mentioned reflective material, it is more preferred that it is not less than 2.3.

The reflectance of the aluminum nitride sintered compact in which the material of refractive index not less than 2.3 was formed tends to improve into not less than 50%.

As for the refractive index of the above-mentioned reflective material, it is still more preferred that it is not less than 2.4.

The reflectance of the aluminum nitride sintered compact in which the material of refractive index not less than 2.4 was formed tends to improve into not less than 70%.

It is preferred that it is as high as 30% optical transmissivity as a reflective material which consists of the above-mentioned material of refractive index not less than 2.1, it is more preferred that this optical transmissivity is not less than 50%, and it is still more preferred that this optical transmissivity is not less than 80%.

By raising the optical transmissivity of the material of refractive index not less than 2.1 which is used as a reflective material, the absorption and scattering etc. of luminescence from the light emitting device are prevented by this reflective material, and it becomes easier to generate the total reflection function of this reflective material.

The above-mentioned refractive index and optical transmissivity are usually to the light of the range of 200 nm-800 nm wavelength at least.

As the above-mentioned reflective material which has refractive index not less than 2.1, the material which comprises as the main ingredients metal or alloy material, an element simple substance, a metal oxide, a metal nitride, metal carbide, a metal silicide, etc. can be used. More concretely, for example, the material which comprises as the main ingredients TiO₂, BaTiO₃, SrTiO₃, CaTiO₃, PbTiO₃, PZT[Pb(Zr, Ti)O₃], PLZT[(Pb, La)(Zr, Ti)O₃], PLT[(Pb, La)TiO₃], ZrO₂, ZnO, ZnSe, Nb₂O₅, Ta₂O₅, LiNbO₃, LiTaO₃, SBN[(Sr1-xBax)Nb₂O₆], BNN(Ba₂NaNb₅O₁₅), Bi₁₂GeO₂₀, Bi₁₂TiO₂₀, Bi₂WO₆, PbMoO₄, PbMoO₅, TeO₂, SiC, Si₃N₄, diamond, Si, Ge, and chalcogenide glass etc. can be used suitably.

Among the above-mentioned materials, what comprises TiO₂, SrTiO₃, PbTiO₃, PZT[Pb(Zr, Ti)O₃], PLZT[(Pb, La)(Zr, Ti)O₃], PLT[(Pb, La)TiO₃], ZnSe, Nb₂O₅, Bi₁₂GeO₂₀, Bi₁₂TiO₂₀, Bi₂WO₆, TeO₂, SiC, diamond, and chalcogenide glass etc. as the main ingredients is more preferred, because what is refractive index not less than 2.4 is easy to be obtained. Moreover, among the above-mentioned materials, what comprises TiO₂, SrTiO₃, PbTiO₃, Bi₁₂GeO₂₀, Bi₁₂TiO₂₀, and Bi₂WO₆, etc. as the main ingredients is still more preferred, because the reflectance of this substrate tends to become not less than 90% when they are formed on the substrate which consists of a sintered compact which comprises an aluminum nitride as the main ingredients.

Moreover, among the above-mentioned materials, what comprises TiO₂ as the main ingredients is especially preferred, because the thing whose reflectance of this substrate is as high as around 95% is easy to be obtained when it is formed on the substrate which consists of a sintered compact which comprises an aluminum nitride as the main ingredients.

As for such material which comprises as the main ingredients metal or alloy material, an element simple substance, a metal oxide, a metal nitride, metal carbide, a metal silicide, etc., not only what is the state of crystalline material but also what is an amorphous state can be used.

As the method of forming the above-mentioned reflective material which consists of a material of refractive index not less than 2.1 into the substrate for light emitting device mounting, there are methods, like how to join the reflective material which was made into the shape of a board or the shape of foil to this substrate for light emitting device mounting by using adhesives, solder, braze material, etc. or by being stuck by pressure, for example, how to join what made the above-mentioned material of refractive index not less than 2.1 the shape of a thin film by sputter, vapor deposition, ion-plating, plating, CVD, a spin coat, and the method of immersing to sol-gel paste etc. to this substrate for light emitting device mounting, how to join the above-mentioned powder paste and sol-gel paste which comprise a material of refractive index not less than 2.1 as the main ingredients etc. to this substrate for light emitting device mounting as a thick film by co-firing with the sintered compact which comprises an aluminum nitride as the main ingredients or by printing later on the already produced sintered compact which comprises an aluminum nitride as the main ingredients, etc., they can be selected suitably.

To the substrate for light emitting device mounting according to this invention which consists of a sintered compact which comprises an aluminum nitride as the main ingredients, the above-mentioned reflective material can form suitably in arbitrary positions according to the purpose, such as the surface on which the light emitting device is mounted as illustrated to FIG. 90, FIG. 91, and FIG. 92, or the side which forms the cavity space of the substrate for light emitting device mounting which has cavity space, or the lid of the substrate for light emitting device mounting which has cavity space etc.

In this invention, since the sintered compact which comprises an aluminum nitride as the main ingredients and which has optical permeability can be used as a substrate for light emitting device mounting, even if this reflective material is in the inside of the sintered compact which comprises an aluminum nitride as the main ingredients, it can generate the reflective function.

If using the substrate which has optical permeability, the light from a light emitting device arrives even at the inside of the substrate in which the reflective material was formed, and the reflective function can be generated by this reflective material.

That is, this reflective material can be formed in one of the inside or the surface of a sintered compact which comprises an aluminum nitride as the main ingredients if needed, and can also be simultaneously formed in both of the inside and surface of the sintered compact which comprises an aluminum nitride as the main ingredients if needed.

As the method of forming a reflective material in the inside of substrate for light emitting device mounting, there are methods, like how to join what made the above-mentioned various metal material, alloy material, or material of refractive index not less than 2.1 the shape of a board or the shape of foil by using adhesives, solder, braze material, etc. or by being stuck by pressure by sandwiching with this substrate for light emitting device mounting, for example, how to join these substrates for light emitting device mounting each other after what made these various glass material, resin material, and inorganic material the shape of a thin film by sputter, vapor deposition, ion-plating, plating, CVD, a spin coat, etc. is formed on two or more substrates for light emitting device mounting, or the method of forming by performing the co-firing of the powder paste etc. which comprise as the main ingredients these various glass materials and inorganic materials with the sintered compact which comprises an aluminum nitride as the main ingredients, or how to join these substrates for light emitting device mounting each other after forming the powder paste and sol gel paste etc. which comprise as the main ingredients these various glass materials, resin materials, and inorganic materials on two or more substrates for light emitting device mounting by printing later or pasting up to the already produced sintered compact which comprises an aluminum nitride as the main ingredients, they can be selected suitably.

FIG. 103 is a sectional view showing a situation whose reflective material is being formed in the inside of the sintered compact which comprises an aluminum nitride as the main ingredients.

In FIG. 103, the reflective material 80 is being formed in the inside of the portion in which the light emitting device of the substrate for light emitting device mounting 30 which consists of a sintered compact which comprises an aluminum nitride as the main ingredients and has cavity space 31 is mounted and the inside of the side wall 33 which forms cavity space.

Thus, this reflective material can be formed in one of the inside or the surface of a sintered compact which comprises an aluminum nitride as the main ingredients, and can also be simultaneously formed in both of the inside and surface of the sintered compact which comprises an aluminum nitride as the main ingredients.

As illustrated in above-mentioned FIG. 87-FIG. 92, not only what formed the reflective prevention material and the reflective material individually respectively to the substrate for light emitting device mounting but also what formed the reflective prevention material and the reflective material simultaneously in the substrate for light emitting device mounting which consists the same sintered compact which comprises an aluminum nitride as the main ingredients is included in this invention.

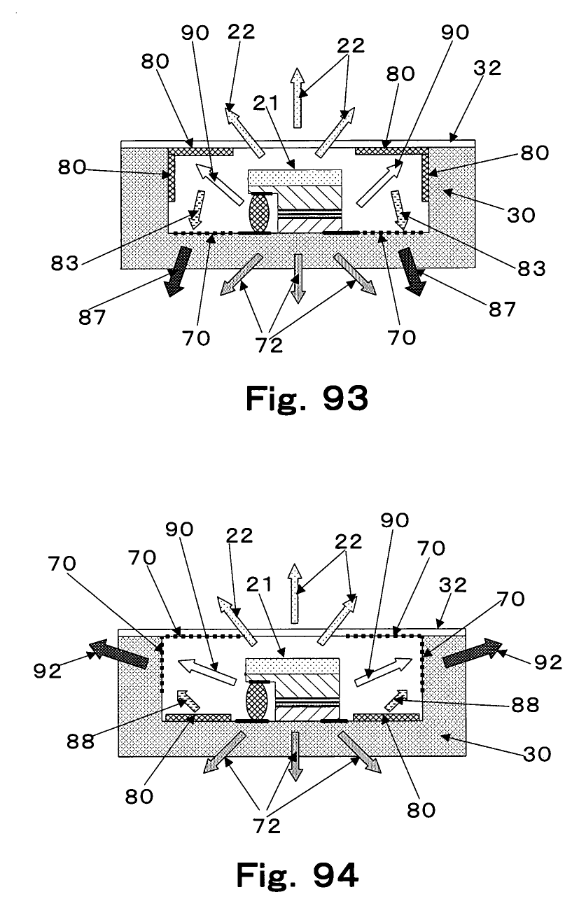

Such substrate for light emitting device mounting is illustrated in FIGS. 93 and FIG. 94.

FIG. 93 and FIG. 94 are sectional view of what formed simultaneously the above-mentioned reflective prevention material and reflective material in the same substrate for light emitting device mounting.

In the substrate for light emitting device mounting which consists of a sintered compact which comprises an aluminum nitride as the main ingredients and formed simultaneously the reflective prevention material and the reflective material, this reflective prevention material or a reflective material may be what was formed only in one of the insides or the surfaces of a sintered compact which comprise an aluminum nitride as the main ingredients, or may be what was formed in both of the inside and surface of a sintered compact which comprises an aluminum nitride as the main ingredients.

The substrate for light emitting device mounting illustrated in FIG. 93 is that whose reflective prevention material 70 is formed furthermore on the substrate surface on which the light emitting device of the substrate for light emitting device mounting in which the reflective material which was indicated in FIG. 91 is already formed was mounted.

In the substrate for light emitting device mounting 30 which consists of a sintered compact which comprises an aluminum nitride as the main ingredients and was shown in FIG. 93, reflected light 83 is once irradiated to the reflective prevention material 70, penetrates the substrate which consists of a sintered compact which comprises an aluminum nitride as the main ingredients, and is emitted to the substrate exterior as a light 87 from the surface on which the light emitting device was mounted.

This emitted light 87 tends to become what has intensity higher than the emitted light 84 shown in FIG. 91. The substrate for light emitting device mounting illustrated in FIG. 94 was that whose reflective material 80 is formed furthermore on the substrate surface in which the light emitting device of the substrate for light emitting device mounting in which the reflective prevention material indicated in FIG. 88 is already formed was mounted.

In the substrate for light emitting device mounting 30 which consists of a sintered compact which comprises an aluminum nitride as the main ingredients and was shown in FIG. 94, the intensity of the luminescence 92 from the light emitting device which is emitted to the substrate exterior from the side wall part which forms cavity space and a lid 32 will tend to become high if compared with the case where the reflective material 80 is not formed because the reflected light 88 by a reflective material is added.

The light emitted to the exterior from the substrate surface where the reflective material 80 is formed and the light emitting device is mounted will tend to become weak.

As the substrate for light emitting device mounting which has the cavity space on which the reflective prevention material and reflective material are being formed and which was illustrated in FIG. 87-FIG. 94, what was formed by joining a base 34 and a frame 35 at the junction part 36, as shown in the above-mentioned FIG. 83, can be used.

In the substrate for light emitting device mounting which has the cavity space and was obtained by joining a base and a frame, it is either, either of a base or a frame consists of a sintered compact which comprises an aluminum nitride as the main ingredients and which has optical permeability, or both a base and a frame consist of a sintered compact which comprises an aluminum nitride as the main ingredients and has optical permeability.

As the substrate for light emitting device mounting in which the reflective prevention material and reflective material are being formed and which has the cavity space and was illustrated in FIG. 87-FIG. 94, the substrate for light emitting device mounting 30 and the lid 32 which were illustrated in the above-mentioned FIG. 84 can be used.

In case the substrate for light emitting device mounting in which the reflective prevention material and reflective material are being formed and which has the cavity space and was illustrated in FIG. 87-FIG. 94 is used, the material which comprises as the main ingredients various metal, alloy, glass, ceramics, resin, etc. can use as a material of a lid.

If the sintered compact which comprises an aluminum nitride as the main ingredients and which has optical permeability and the transparent glass, resin, ceramics, etc. are used as a material of a lid 32, since it can emit to the substrate exterior from a lid 32, without losing luminescence from a light emitting device not much, it is desirable.

If what comprises as the main ingredients various metals, alloys, glasses, ceramics (the sintered compact of optical impermeableness which comprises an aluminum nitride as the main ingredients and cannot penetrate light easily is included), resins etc. which cannot penetrate light easily and are optical impermeableness is used as a material of a lid 32, since luminescence from a light emitting device stops being able to penetrate a lid 32 easily, it is effective when it does not wanted to emit this luminescence into the direction in which a lid 32 is attached.

Hermetic seal will be attained, if metal, alloy, glass, ceramics, etc. are used as a material of a lid 32 and solder, braze material, glass, etc. are used as a sealing agent on the occasion of seal.

In addition, it is not necessary to use a lid 32 if needed.

In that case, seal of a light emitting device can be performed by filling up cavity space 31 with transparent resin etc.

As for the sintered compact which comprises an aluminum nitride as the main ingredients and is used as a substrate for light emitting device mounting in this invention, what has optical permeability is preferred.

In each figure (FIG. 87-FIG. 94) which illustrated the state where the above-mentioned reflective prevention material and the reflective material were formed, FIG. 87, FIG. 88, FIG. 90, FIG. 91, FIG. 92, FIG. 93, and FIG. 94 at least are drawn as that whose sintered compact which comprises an aluminum nitride as the main ingredients and is used as a substrate for light emitting device mounting has optical permeability.

As mentioned above, according to this invention, it becomes possible to control comparatively easily the intensity of luminescence from a light emitting device or the direction of luminescence by using a reflective prevention material or a reflective material in the substrate for light emitting device mounting, or by using a reflective prevention material and a reflective material simultaneously.

According to this invention, it is also possible to control the intensity of luminescence from a light emitting device or the direction of luminescence comparatively easily without especially using materials, such as a reflective prevention material or a reflective material, other than the sintered compact which comprises an aluminum nitride as the main ingredients, or without adding other reflective prevention functions and reflective functions to the substrate for light emitting device mounting.

That is, if the sintered compact which comprises an aluminum nitride as the main ingredients and is the optical transmissivity not more than 50% is used as a substrate for light emitting device mounting, it is possible to emit luminescence from a light emitting device efficiently into the specific direction of a substrate on which a light emitting device is mounted.

This method has the feature that enables luminescence from a light emitting device to emit efficiently into the specific direction of the substrate exterior by the sintered compact which comprises an aluminum nitride as the main ingredients and is used as a material of the substrate for light emitting device mounting and whose optical transmissivity itself is not more than 50%, without depending on addition of the above-mentioned reflective prevention material or the reflective material, or addition of the other reflective prevention functions or reflective functions.

That is, as for the optical transmissivity of the sintered compact which comprises an aluminum nitride as the main ingredients and which is used as the material of a substrate for light emitting device mounting, by making it into not more than 50% itself, luminescence from a light emitting device is emitted strongly to the substrate surface side on which the light emitting device is mounted, and the light emitted from the substrate of the side opposite to the substrate surface on which the light emitting device is mounted is decreased.

According to this method, it is also possible that the light emitted from the substrate of the side opposite to the substrate surface on which the light emitting device is mounted becomes zero by emitting the luminescence from the above-mentioned light emitting device strongly only from the substrate surface side on which the light emitting device is mounted.

In this method, it is preferred to use the sintered compact which comprises an aluminum nitride as the main ingredients and is the optical transmissivity not more than 50%, as a substrate for light emitting device mounting.

If the sintered compact which comprises an aluminum nitride as the main ingredients and is the optical transmissivity not more than 50% is used as a substrate for light emitting device mounting, emitting from a direction opposite to the substrate surface side on which the light emitting device is mounted is easy to be prevented by that whose luminescence from a light emitting device penetrates a substrate, and strong light emitting becomes easy to be performed efficiently from the substrate surface side on which the light emitting device is mounted.

In the above substrate for light emitting device mounting, a more effect comes to be acquired using the sintered compact which comprises an aluminum nitride as the main ingredients and is the optical transmissivity not more than 30%.

In the above substrate for light emitting device mounting, a more effect comes to be clearly accepted using the sintered compact which comprises an aluminum nitride as the main ingredients and is the optical transmissivity not more than 10%.

In the above substrate for light emitting device mounting, a still more effect comes to be accepted more clearly using the sintered compact which comprises an aluminum nitride as the main ingredients and is the optical transmissivity not more than 5%.

In the above substrate for light emitting device mounting, if the sintered compact which comprises an aluminum nitride as the main ingredients and is the optical transmissivity not more than 1% is used, since emitting is substantially hard coming to occur from a direction opposite to the substrate surface side on which the light emitting device is mounted by that whose luminescence from a light emitting device penetrates the substrate for light emitting device mounting, it is preferred especially.

In the above substrate for light emitting device mounting, if the sintered compact which comprises an aluminum nitride as the main ingredients and whose optical transmissivity is o% is used, since emitting does not substantially occur from a direction opposite to the substrate surface side on which the light emitting device is mounted by that whose luminescence from a light emitting device penetrates the substrate for light emitting device mounting, it is the most desirable.

In this method, if the sintered compact which comprises an aluminum nitride as the main ingredients and has optical permeability and whose optical transmissivity exceeds 50% is used as a substrate for light emitting device mounting, since luminescence from a light emitting device penetrates the substrate and it is easy to come to emit a many to the substrate exterior also from the surface opposite to the substrate surface on which a light emitting device is mounted or contained, it is not desirable.

Therefore, it cannot be said that it is appropriate to use the above sintered compact which comprises an aluminum nitride as the main ingredients and has the optical permeability whose optical transmissivity exceeds 50% as a substrate for light emitting device mounting in order to emit luminescence from a light emitting device into the specific direction efficiently.

When the sintered compact which comprises an aluminum nitride as the main ingredients and is the range whose optical transmissivity is 30%-50% is used as a substrate for light emitting device mounting by this method, with the naked eye, it is observed that a strong light directly emitted from this light emitting device is emitted from the substrate surface side on which the light emitting device was mounted, the weaker and gentler scattered light than it is emitted from the surface of the side opposite to the substrate surface on which the light emitting device was mounted.

When the optical transmissivity of a sintered compact which comprises an aluminum nitride as the main ingredients and which is used as a substrate for light emitting device mounting is in the range of 10%-30%, a situation in which the above-mentioned gentle scattered light which is emitted from the surface of a side opposite to the substrate surface on which the light emitting device was mounted becomes weaker gradually according as the optical transmissivity lowers from 30% to 10% is observed with the naked eye.

At this time, from the substrate surface side on which the light emitting device was mounted, a light stronger than the case where the sintered compact which comprises an aluminum nitride as the main ingredients and whose optical transmissivity is the range of 30%-50% is used is emitted from a light emitting device.

In the range whose optical transmissivity of the sintered compact which comprises an aluminum nitride as the main ingredients and is used as a substrate for light emitting device mounting is 1%-10%, a situation in which the above-mentioned gentle scattered light emitted from the surface of the side opposite to the substrate surface on which the light emitting device was mounted becomes weaker further is observed with the naked eye.

In this range, when the sintered compact which comprises an aluminum nitride as the main ingredients and whose optical transmissivity is not more than 5% is used as a substrate for light emitting device mounting, situation in which the gentle scattered light emitted from the surface of the side opposite to the substrate surface on which the light emitting device was mounted weaker furthermore is observed with the naked eye.

At this time, from the substrate surface side on which the light emitting device was mounted, a light still stronger than the case where the sintered compact which comprises an aluminum nitride as the main ingredients and whose optical transmissivity is the range of 10%-30% is used is emitted from a light emitting device.

If the optical transmissivity of the sintered compact which comprises an aluminum nitride as the main ingredients becomes smaller than 1%, the above-mentioned gentle scattered light from the surface of the side opposite to the substrate surface on which the light emitting device was mounted will become that it is almost hard to be observed with the naked eye, at this time, from the substrate surface side on which the light emitting device was mounted, a light stronger than the case where the sintered compact which comprises an aluminum nitride as the main ingredients and whose optical transmissivity is the range of 1%-10% is used is emitted from a light emitting device.

When the optical transmissivity of the sintered compact which comprises an aluminum nitride as the main ingredients is 0%, the above-mentioned gentle scattered light from the substrate surface on which the light emitting device was mounted, and the surface of the opposite side is no longer observed with the naked eye, at this time, from the substrate surface side on which the light emitting device was mounted, the almost same strong light as the case where the sintered compact which comprises an aluminum nitride as the main ingredients and whose optical transmissivity is smaller than 1% is used is emitted from a light emitting device.

Thus, in this invention, it is more preferred to use that whose optical transmissivity is not more than 30% as a sintered compact which comprises an aluminum nitride as the main ingredients and is used as a substrate for light emitting device mounting.

Furthermore, in this invention, it is still more preferred to use that whose optical transmissivity is not more than 10% as a sintered compact which comprises an aluminum nitride as the main ingredients and which has the shading nature and is used as a substrate for light emitting device mounting.

In this method, the optical transmissivity of the sintered compact which comprises an aluminum nitride as the main ingredients is to the light of the range of 200 nm-800 nm wavelength at least.

In this method, when the substrate thickness is thinner than 0.5 mm at a real busy condition, unlike the optical transmissivity measured at the time of the substrate thickness of 0.5 mm, optical transmissivity tends to rise more highly than 50%, luminescence from a light emitting device penetrates the substrate and it becomes easy to be emitted into the direction of the side opposite to the substrate surface side on which this light emitting device was mounted.

In this invention, it is preferred to use the sintered compact which comprises an aluminum nitride as the main ingredients and whose above-mentioned optical transmissivity in the substrate thickness in the state where it is actually used is not more than 50%

When substrate thickness in a real busy condition is thicker than 0.5 mm, usually it is easy to lower than the optical transmissivity at the time of being measured in 0.5 mm.

In this method, in order to emit luminescence from a light emitting device efficiently to the direction of the substrate surface side on which this light emitting device was mounted, it is preferred to use the sintered compact which comprises an aluminum nitride as the main ingredients and whose optical transmissivity is not more than 50% in the substrate thickness of the state where it is actually used as a substrate for light emitting device mounting.

It has become possible to emit luminescence from a light emitting device efficiently into the specific direction of a substrate on which the light emitting device is mounted by using the sintered compact which comprises an aluminum nitride as the main ingredients and whose optical transmissivity is not more than 50% as a substrate for light emitting device mounting as mentioned above.

Namely, luminescence from a light emitting device can be emitted efficiently to the direction of the substrate surface side on which this light emitting device is mounted. In this method, if a light reflex prevention function or a light reflex function is given to the substrate for light emitting device mounting if needed, it will be possible to emit more effectively and strongly into the specific direction of the substrate exterior.

In other words, it becomes possible to emit luminescence from a light emitting device still more efficiently into the specific direction of a substrate on which the light emitting device is mounted by attaching the reflective prevention material and reflective material according to this invention to the sintered compact which comprises an aluminum nitride as the main ingredients and whose optical transmissivity is not more than 50% if needed.

That is, the effect in which the luminescence from a light emitting device can be emitted efficiently to the direction of the substrate surface side on which this light emitting device was mounted increases further.

Anythings can be used unless the characteristics as an aluminum nitride, such as thermal conductivity or electric insulation, are spoiled as a sintered compact which comprises an aluminum nitride as the main ingredients and which is used for this method and whose optical transmissivity is not more than 50%.

Therefore, as for the content of the aluminum nitride in a sintered compact, it is preferred that it is not less than 50 volume %.

The sintered compact which comprises an aluminum nitride as the main ingredients and whose optical transmissivity is not more than 50% can be usually obtained by what contains the ingredient which promotes coloring of the sintered compact which comprises an aluminum nitride as the main ingredients, such as Mo, W, V, Nb, Ta, Ti, and carbon, and a rare earth element, and the unescapable impurities ingredient of transition metals other than Mo, W, V, Nb, Ta, and Ti, for example, iron, nickel, chromium, manganese, zirconium, hafnium, cobalt, copper, zinc, etc.

As for what generates or contains other than these ingredients, for example, oxygen and ALON which differs from a crystal system of an aluminum nitride, SIALON (compound with silicon, aluminum, oxygen, and nitrogen) which generates by reaction of a silicon content compound and an aluminum nitride, or an alkali metal compound etc. in the sintered compact which comprises an aluminum nitride as the main ingredients, since it is easy to become optical transmissivity not more than 50%, it is desirable.

Although it is usually easy to obtain that whose optical transmissivity is not less than 50% when sintering aids, such as a rare earth element compound and an alkaline-earth-metals compound, are included, for example, since the optical transmissivity of the sintered compact which comprises an aluminum nitride as the main ingredients tends to become not more than 50% when there are many contents of sintering aids, it is desirable.

Since the optical transmissivity of the sintered compact which comprises an aluminum nitride as the main ingredients tends to become not more than 50% when there are many oxygen contents, it is desirable.

The case whose optical transmissivity of the sintered compact which comprises an aluminum nitride as the main ingredients tends to become not more than 1% is in what contains comparatively a lot of a rare earth element or an alkaline-earth metal among the above-mentioned ingredients other than an aluminum nitride.

That is, in the sintered compact which comprises an aluminum nitride as the main ingredients and whose content of at least one or more materials selected from a rare earth element or alkaline-earth metal is more than 30 volume % by oxide conversion, what is the optical transmissivity not more than 1% is easy to obtain.

As for the optical transmissivity of the sintered compact which comprises an aluminum nitride as the main ingredients and whose content of at least one or more materials selected from a rare earth element or alkaline-earth metal is more than 40 volume % by oxide conversion, since it tends to become 0%, it is preferred.

It is preferred that the content of at least one or more materials selected from the above-mentioned rare earth element or alkaline-earth metal is not more than 50 volume % by oxide conversion.

In the sintered compact which comprises an aluminum nitride as the main ingredients and whose content of at least one or more materials selected from the above-mentioned rare earth element or alkaline-earth metal is more than 50 volume % by oxide conversion, since it becomes easy to generate a characteristic lowering, like the lowering of electric insulation and like the thermal conductivity becomes lower than 50 W/mK in room temperature, etc., it is not desirable.

If saying in another word, in the sintered compact which comprises an aluminum nitride as the main ingredients and contains at least one or more materials selected from a rare earth element or an alkaline-earth metal in the range of not more than 50 volume %-40 volume % by oxide conversion, what is the optical transmissivity of 0% is easy to obtain.

In the sintered compact which comprises an aluminum nitride as the main ingredients and contains at least one or more materials selected from a rare earth element or an alkaline-earth metal in the range of not more than 40 volume %-30 volume % by oxide conversion, what is the optical transmissivity not more than 1% is easy to obtain.

As for the case whose optical transmissivity of the sintered compact which comprises an aluminum nitride as the main ingredients tends to become not more than 1%, it is in what contains comparatively a lot of alkaline metals or silicon ingredient among the above-mentioned ingredients other than an aluminum nitride.

That is, in the sintered compact which comprises an aluminum nitride as the main ingredients and whose content of at least one or more materials selected from an alkaline metal or a silicon ingredient is not less than 5 volume % by oxide conversion, what is the optical transmissivity not more than 1% is easy to obtain.

Since the optical transmissivity of the sintered compact which comprises an aluminum nitride as the main ingredients and whose content of at least one or more materials selected from an alkaline metal or a silicon ingredient is not less than 10 volume % by oxide conversion tends to become 0%, it is preferred.

It is preferred that the content of at least one or more materials selected from the above-mentioned alkaline metal or silicon ingredient is not more than 20 volume % by oxide conversion.

In the sintered compact which comprises an aluminum nitride as the main ingredients and whose content of at least one or more materials selected from the above-mentioned alkaline metal or silicon ingredient is more than 20 volume % by oxide conversion, since it becomes easy to generate a characteristic lowering, like the lowering of electric insulation and like the thermal conductivity becomes lower than 50 W/mK in room temperature, etc., it is not desirable.

If saying in another word, in the sintered compact which comprises an aluminum nitride as the main ingredients and contains at least one or more materials selected from an alkaline metal or a silicon ingredient in the range of not more than 20 volume %-10 volume % by oxide conversion, what is the optical transmissivity of 0% is easy to obtain.

Moreover, in the sintered compact which comprises an aluminum nitride as the main ingredients and contains at least one or more materials selected from an alkaline metal or a silicon ingredient in the range of not more than 10 volume %-5 volume % by oxide conversion, what is the optical transmissivity not more than 1% is easy to obtain.

Moreover, the case whose optical transmissivity of the sintered compact which comprises an aluminum nitride as the main ingredients tends to become not more than 1% is in what contains comparatively a lot of Mo, W, V, Nb, Ta, and Ti, and carbon among the above-mentioned ingredients other than an aluminum nitride.

That is, in the sintered compact which comprises an aluminum nitride as the main ingredients and contains at least one or more ingredients selected from Mo, W, V, Nb, Ta, Ti, and carbon not less than 5 volume % by element conversion, what is the optical transmissivity not more than 1% is easy to obtain.

Moreover, as for the optical transmissivity of the sintered compact which comprises an aluminum nitride as the main ingredients and contains at least one or more ingredients selected from Mo, W, V, Nb, Ta, Ti, and carbon not less than 20 volume % by element conversion, since it tends to become 0%, it is desirable.

As for the above-mentioned content of at least one or more ingredients selected from Mo, W, V, Nb, Ta, Ti, and carbon, it is desirable that it is not more than 50 volume % by element conversion.

In the sintered compact which comprises an aluminum nitride as the main ingredients and whose content of at least one or more materials selected from above Mo, W, V, Nb, Ta, Ti, and carbon is more than 50 volume % by element conversion, since a characteristic lowering becomes easy to generate, like the electric resistivity in room temperature becomes lower than 1×10⁸ Ω·cm by lowering of an electric insulation or like the thermal conductivity becomes lower than 50 W/mK in room temperature, etc., it is not desirable.

Moreover, in the sintered compact which comprises an aluminum nitride as the main ingredients and whose content of at least one or more materials selected from above Mo, W, V, Nb, Ta, Ti, and carbon is not more than 20 volume % by element conversion, since an electric insulation improves and what is not less than 1×10⁹ Ω·cm of electric resistivity in room temperature becomes easy to acquire, it is desirable.

Moreover, in the sintered compact which comprises an aluminum nitride as the main ingredients and whose content of at least one or more materials selected from above Mo, W, V, Nb, Ta, Ti, and carbon is not more than 5 volume % by element conversion, since an electric insulation improves more and what is not less than 1×10¹¹ Ω·cm of electric resistivity in room temperature becomes easy to acquire, it is more desirable.

If saying in another word, in the sintered compact which comprises an aluminum nitride as the main ingredients and contains at least one or more ingredients selected from Mo, W, V, Nb, Ta, Ti, and carbon in the range of not more than 50 volume %-20 volume % by element conversion, what is the optical transmissivity of 0% is easy to obtain.

Moreover, in the sintered compact which comprises an aluminum nitride as the main ingredients and contains at least one or more ingredients selected from Mo, W, V, Nb, Ta, Ti, and carbon in the range of not more than 20 volume %-5 volume % by element conversion, it will be easy to obtain what is the optical transmissivity not more than 1%.

In the sintered compact which comprises an aluminum nitride as the main ingredients and whose content of at least one or more ingredients selected from Mo, W, V, Nb, Ta, Ti, and carbon is not more than 10 volume % by element conversion, it is easy to obtain that whose electric insulation improved like not less than 1×10¹⁰ Ω·cm of electric resistivity in room temperature.

Moreover, the case whose optical transmissivity of the sintered compact which comprises an aluminum nitride as the main ingredients tends to become not more than 1% is what contains comparatively a lot of unescapable impurities ingredients of transition metals other than a rare earth element and Mo, W, V, Nb, Ta, and Ti among the above-mentioned ingredients other than an aluminum nitride.

That is, in the sintered compact which comprises an aluminum nitride as the main ingredients and contains at least one or more ingredients selected from iron, nickel, chromium, manganese, zirconium, hafnium, cobalt, copper, zinc, etc. not less than 1 weight % by element conversion, it is easy to obtain what is the optical transmissivity not more than 1%.

Moreover, since the optical transmissivity of the sintered compact which comprises an aluminum nitride as the main ingredients and contains at least one or more ingredients selected from iron, nickel, chromium, manganese, zirconium, hafnium, cobalt, copper, and zinc not less than 20 weight % by element conversion tends to become 0%, it is desirable.

As for the content of at least one or more ingredients selected from the above-mentioned iron, nickel, chromium, manganese, zirconium, hafnium, cobalt, copper, and zinc, it is desirable that it is not more than 50 weight % by element conversion.

In the sintered compact which comprises an aluminum nitride as the main ingredients and whose content of at least one or more ingredients selected from the above-mentioned iron, nickel, chromium, manganese, zirconium, hafnium, cobalt, copper, and zinc is more than 50 weight % by element conversion, since a characteristic lowering becomes easy to generate, like the electric resistivity in room temperature becomes lower than 1×10⁸ Ω·cm by lowering of an electric insulation or like the thermal conductivity becomes lower than 50 W/mK in room temperature, etc., it is not desirable.

Moreover, in the sintered compact which comprises an aluminum nitride as the main ingredients and whose content of at least one or more ingredients selected from the above-mentioned iron, nickel, chromium, manganese, zirconium, hafnium, cobalt, copper, and zinc is not more than 20 weight % by element conversion, since an electric insulation improves and what is not less than 1×10⁹ Ω·cm of electric resistivity in room temperature becomes easy to acquire, it is desirable.

Moreover, in the sintered compact which comprises an aluminum nitride as the main ingredients and whose content of at least one or more ingredients selected from the above-mentioned iron, nickel, chromium, manganese, zirconium, hafnium, cobalt, copper, and zinc is not more than 1 weight % by element conversion, since an electric insulation improves more and what is not less than 1×10¹¹ Ω·cm of electric resistivity in room temperature becomes easy to acquire, it is more desirable.

If saying in another word, in the sintered compact which comprises an aluminum nitride as the main ingredients and contains at least one or more ingredients selected from iron, nickel, chromium, manganese, zirconium, hafnium, cobalt, copper, and zinc in the range of not more than 50 weight %-20 weight % by element conversion, it is easy to obtain what is the optical transmissivity of 0%.

Moreover, in the sintered compact which comprises an aluminum nitride as the main ingredients and contains at least one or more ingredients selected from iron, nickel, chromium, manganese, zirconium, hafnium, cobalt, copper, and zinc in the range of not more than 20 weight %-1 weight % by element conversion, it is easy to obtain what is the optical transmissivity not more than 1%.

In the above-mentioned sintered compact which comprises an aluminum nitride as the main ingredients and contains at least one or more ingredients selected from iron, nickel, chromium, manganese, zirconium, hafnium, cobalt, copper, and zinc not more than 10 weight % by element conversion, it becomes easy to obtain what is not less than 1×10¹⁰ Ω·cm of electric resistivity in room temperature.

In addition, unless it refused especially in this invention, “the unescapable impurities ingredient of a transition metal” means usually iron, nickel, chromium, manganese, zirconium, hafnium, cobalt, copper, and zinc.

Moreover, “containing the unescapable impurities ingredient of a transition metal” means that at least one or more materials of each ingredient, such as the above-mentioned iron , nickel, chromium, manganese, zirconium, hafnium, cobalt, copper, and zinc, are included.

Moreover, the case whose optical transmissivity of the sintered compact which comprises an aluminum nitride as the main ingredients tends to become not more than 1% is in what contains comparatively a lot of oxygen among the above-mentioned ingredients other than an aluminum nitride.

That is, in the sintered compact which comprises an aluminum nitride as the main ingredients and contains oxygen not less than 10 weight %, it is easy to obtain what is the optical transmissivity not more than 1%.

Moreover, since the optical transmissivity of the sintered compact which comprises an aluminum nitride as the main ingredients and contains oxygen not less than 15 weight % tends to become 0%, it is desirable.

It is desirable that the above-mentioned oxygen content is not more than 25 weight %.

In the sintered compact which comprises an aluminum nitride as the main ingredients and whose above-mentioned content of oxygen is more than 25 weight %, since it becomes easy to generate a characteristic lowering, like the lowering of electric insulation and like the thermal conductivity becomes lower than 50 W/mK in room temperature, etc., it is not desirable.

If saying in another word, in the sintered compact which comprises an aluminum nitride as the main ingredients and contains oxygen in the range of not more than 25 weight %-15 weight %, it is easy to obtain what is the optical transmissivity of 0%.

Moreover, in the sintered compact which comprises an aluminum nitride as the main ingredients and contains oxygen in the range of not more than 15 weight %-10 weight %, it is easy to obtain what is the optical transmissivity not more than I %.

In addition, in this invention, as for the sintered compact which comprises an aluminum nitride as the main ingredients, even if it is a thing only containing the oxygen of a quantity smaller than the above range, like the case where the sintered compact which comprises an aluminum nitride as the main ingredients contains a rare earth element compound and an alkaline-earth-metals compound, or the case where an alkaline metal compound and a silicon content compound are included, or the case where Mo, W, V, Nb, Ta, Ti, carbon, etc. are included, or the case where unescapable metal ingredients, such as iron, nickel, chromium, manganese, zirconium, hafnium, cobalt, copper, and zinc, are included, etc., optical transmissivity may lower.

Moreover, conversely, even if the oxygen of more quantity than the above range is included, without lowering the optical transmissivity, what has comparatively high optical transmissivity may be obtained.

That is, in this invention, in the case where the sintered compact which comprises an aluminum nitride as the main ingredients contains a rare earth element compound and an alkaline-earth-metals compound, or in the case where an alkaline metal compound and a silicon content compound are included, or in the case where Mo, W, V, Nb, Ta, Ti, carbon, etc. are included, or in the case where unescapable metal ingredients, such as iron, nickel, chromium, manganese, zirconium, hafnium, cobalt, copper, and zinc, are included, even if the amount of oxygen contained is up to the range of not more than 15 weight %-10 weight %, what is the optical transmissivity of 0% may arise.

If ingredients other than the above-mentioned aluminum nitride are contained, a complicated compound will probably generate during the firing, it will deposit as the grain boundary phase of a sintered compact, and it will be guessed that the optical transmissivity becomes easy to be prevented.

Moreover, in this invention, in the case where the sintered compact which comprises an aluminum nitride as the main ingredients contains a rare earth element compound and an alkaline-earth-metals compound, or in the case where an alkaline metal compound and a silicon content compound are included, or in the case where Mo, W, V, Nb, Ta, Ti, carbon, etc. are included, or in the case where unescapable metal ingredients, such as iron, nickel, chromium, manganese, zirconium, hafnium, cobalt, copper, and zinc, are included, even if the amount of oxygen contained is up to the range of not more than 25 weight %-15 weight %, the thing whose optical transmissivity is larger than 0%, and what is not less than 1% may generate. It is guessed that because the above-mentioned ingredients other than aluminum nitride probably take in oxygen from an aluminum nitride particle etc. effectively, for example, make it deposit as a grain boundary phase, and prevent decline in the optical transmissivity by oxygen.

Moreover, the case whose optical transmissivity of the sintered compact which comprises an aluminum nitride as the main ingredients tends to become not more than 1% is in what contains comparatively a lot of ALON among the above-mentioned ingredients other than an aluminum nitride.

That is, in the sintered compact which comprises an aluminum nitride as the main ingredients and contains ALON not less than 20%, what is the optical transmissivity not more than 1% tends to be obtained.

Moreover, since the optical transmissivity of the sintered compact which comprises an aluminum nitride as the main ingredients and contains ALON not less than 40% tends to become 0%, it is desirable.

It is desirable that the above-mentioned content of ALON is not less than 50%.

In the sintered compact which comprises an aluminum nitride as the main ingredients and whose above-mentioned content of ALON is more than 50%, since it becomes easy to generate a characteristic lowering, like the lowering of electric insulation and like the thermal conductivity becomes lower than 50 W/mK in room temperature, etc., it is not desirable.

If saying in another word, in the sintered compact which comprises an aluminum nitride as the main ingredients and contains ALON in the range of not more than 50%-40%, it is easy to obtain what is the optical transmissivity of 0%.

Moreover, in the sintered compact which comprises an aluminum nitride as the main ingredients and contains ALON in the range of not more than 40%-20%, it is easy to obtain what is the optical transmissivity not more than 1%.

In addition, the above-mentioned content of ALON is what asked for the ratio as a percentage by comparing each strongest diffraction line of ALON and AlN by the X-ray diffraction method as mentioned above.

As for the sintered compact which comprises an aluminum nitride as the main ingredients and contained simultaneously two or more of comparatively a lot of sintering aids, such as rare earth element compounds and alkaline-earth-metals compounds, or ingredients, such as an alkaline metal and silicon, or the ingredient for promoting coloring of sintered compacts, such as Mo, W, V, Nb, Ta, Ti, and carbon, or unescapable metal ingredients, such as iron, nickel, chromium, manganese, zirconium, hafnium, cobalt, copper, and zinc, or oxygen, which are used in order to make optical transmissivity of the sintered compact which comprises an aluminum nitride as the main ingredients not more than 50% as mentioned above, it can also be used as a substrate for light emitting device mounting.

For example, in the case of the sintered compact which comprises an aluminum nitride as the main ingredients and which contains simultaneously at least one or more ingredients selected from a rare earth element and an alkaline-earth metal, and at least one or more ingredients selected from ingredients, such as an alkaline metal and silicon, or ingredients, such as Mo, W, V, Nb, Ta, Ti, and carbon, or unescapable metal ingredients, such as iron, nickel, chromium, manganese, a zirconium, hafnium, cobalt, copper, and zinc, or oxygen, since the firing temperature at the time of sintered compact manufacture can be lowered compared with the case where a rare earth element and ana lkaline-earth metal are not included, and manufacture becomes easy, it is desirable.

If the substrate for light emitting device mounting according to this invention which comprises an aluminum nitride as the main ingredients and is the optical transmissivity not more than 50% is used, emitting of a strong light becomes possible from the substrate surface side on which the light emitting device was mounted, it is suitably applicable for plane-like lighting which needs a luminescence to a specific direction, for example, wall panel lighting or ceiling lighting, etc.

When two or more plurality of light emitting devices were mounted on the substrate for light emitting device mounting according to this invention, the direction of luminescence from each light emitting device can be controlled individually by changing the material of a reflective prevention material or a reflective material, a formation position, and form etc., by each light emitting device mounting portion within the same substrate

As a result, the light emitted from the whole substrate becomes what received control of a direction and control of brightness more highly, there is an advantage, for example, of being able to be irradiated locally more brightly than the light from two or more substrates on which only one light emitting device was mounted.

Even if the light emitted to the substrate exterior by mounting two or more plurality of light emitting devices on the substrate for light emitting device mounting is that whose brightness increased locally, the light which penetrated the substrate for light emitting device mounting which consists of a sintered compact which comprises an aluminum nitride as the main ingredients is what is gentle to an eye, and quiet.

### EXAMPLE 36

The influence by the characteristics, such as composition of a sintered compact and microstructure of a sintered compact, was investigated about the optical permeability of the sintered compact which comprises an aluminum nitride as the main ingredients. Moreover, it investigated about the quality of the light which penetrates the substrate when using the obtained various sintered compacts as a substrate for light emitting device mounting. High purity aluminum nitride powder (grade “F” by Tokuyama Soda Co., Ltd. (present: Tokuyama, Inc.)) was prepared as raw powder for sintered compact production.

This raw powder is manufactured by the oxide reduction method.

This raw powder contains oxygen 0.9 weight % as impurities.

Sintering aids, and a black-ized agent, etc. are added suitably to this raw powder, and they were mixed with ethanol by a ball mill for 24 hours, then dried and ethanol was vaporized, and the powder for moulding was produced by adding a paraffine wax of 5 weight % to a mixture powder, the circular compact with a diameter of 32 mm×thickness of 1.5 mm was acquired by uniaxial press molding.

Paraffine wax is degreased at 300 degrees C. under decompression after that, and the various sintered compacts which comprise an aluminum nitride as the main ingredients were obtained by normal pressure sintering, atmospheric pressure sintering (gas pressure sintering), hotpress, and HIP (hot isostatic press: hydrostatic pressure sintering) in the pure nitrogen atmosphere so that it may not become reduced atmosphere by using the setter and saggar which are made from an aluminum nitride or tungsten as an firing implement.

Grinding of the obtained sintered compact is carried out to a size with a diameter of 25.4 mm×thickness of 0.5 mm, furthermore, specular surface polish processing of the surface was carried out.

In addition, on the occasion of the firing of the above-mentioned powder compact, as for what does not use an additive, what contains calcium carbonate 3.0 volume % by oxide conversion as an additive, what contains Si and Si₃N₄ 0.02 volume % and 2.5 volume %, respectively, by oxide conversion, normal pressure sintering or atmospheric pressure sintering was performed by using what is made from tungsten in the state as it is as an firing implement.

On the occasion of the firing of the powder compact of the other composition, the produced powder compact was set to the setter made from tungsten by using only the prepared aluminum nitride powder simultaneously and fired, or was fired by using the setter made from an aluminum nitride.

Moreover, on the occasion of a hotpress and HIP, other than what does not use an additive, pressurization sintering was performed by using what once carried out normal pressure sintering of the powder compact at 1820 degrees C. for 1 hour in nitrogen, and was once made into the sintered compact.

As for the obtained various sintered compacts which comprise an aluminum nitride as the main ingredients, composition, relative density, the average size of a pore, the size of an AlN particle, the total amount of oxygen, the amount of ALON, the optical transmissivity using 605 nm monochromatic light, and the smooth nature of a substrate surface after polishing this sintered compact which comprises an aluminum nitride as the main ingredients were measured.

The measurement result of the characteristic of the above-mentioned sintered compact which comprises an aluminum nitride as the main ingredients is shown in Table 52.

In the obtained various sintered compacts which comprise an aluminum nitride as the main ingredients, what exists in raw powder as impurities and oxygen mixed from the added alumina, or added sintering aids, such as a rare earth element compound and an alkaline-earth-metals compound, or added alkaline metal compound and a silicon contained compound, or the added ingredients which promote coloring, such as molybdenum, tungsten, niobium, titanium, carbon, etc., or added ingredients, such as iron and nickel, are existing as same amount as the inside of a powder compact without almost vaporizing and removing the additive added to raw powder.

That is, the composition of the obtained sintered compact which comprises an aluminum nitride as the main ingredients is same as the composition of a powder compact.

Therefore, as the composition of an obtained sintered compact which comprises an aluminum nitride as the main ingredients, it has not indicated especially except the total amount of oxygen in Table 52.

When producing the above-mentioned sintered compact which comprises an aluminum nitride as the main ingredients, the added amount of alumina is calculated by oxide conversion, and the amount of oxygen in the sintered compact which comprises an aluminum nitride as the main ingredients is measured by element conversion.

In addition, although the surface smooth nature of a substrate was not shown in Table 52, it was in the range of average surface roughness (Ra)=20 nm-45 nm.

Then, various substrates with a diameter of 25.4 mm×thickness of 0.5 mm which carried out specular surface polish processing of the above-mentioned surface were cut in a 10 mm×10 mm size, and the electric circuit for driving a light emitting device with a width of 50 μm by a Ti/Pt/Au thin film was formed in one side, and the substrate for light emitting device mounting was produced.

The commercial light emitting device which laminated the epitaxial film which comprises as the main ingredients at least one or more materials selected from a gallium nitride, an indium nitride, and an aluminum nitride, and was produced by using a mixed crystal thin film of 1 nN and GaN as a luminescence layer was mounted on the produced substrate, 3.5 V×350 mA electric power is impressed, and is made to emit light, then the penetration state from the substrate of this luminescence was confirmed with the naked eye.

In addition, the center luminescence wavelength of the above-mentioned light emitting device is 460 nm.

In Table 52, in all the substrates which use the sintered compact which comprises an aluminum nitride as the main ingredients except for the substrate produced by experiment No. 6, luminescence from a light emitting device was observed in the side opposite to the substrate surface on which the light emitting device was mounted

This shows that luminescence from a light emitting device penetrates a substrate and it is emitted to the substrate exterior by using that whose optical transmissivity of the sintered compact which comprises an aluminum nitride as the main ingredients is not less than 1% as a substrate.

In the sintered compact of experiment No. 6 which comprises an aluminum nitride as the main ingredients, the content of ALON is not less than 50%, it seems that it is hard to generate optical permeability since AlN content is smaller than 50% and oxygen is also more than 10 weight %.

In Table 52, in the sintered compact which comprises an aluminum nitride as the main ingredients and whose content of a rare earth element compound containing each element of Y, Gd, Dy, Ho, Er, and Yb, and an alkaline-earth-metals compound containing calcium is not more than 30 volume % by oxide conversion, respectively, the optical transmissivity is not less than 1%, what was obtained in practice was what has the optical transmissivity at least not less than 20%.

In the sintered compact which comprises an aluminum nitride as the main ingredients and whose content of an alkali metal compound containing Li, and a silicon compound is not more than 5 volume %, respectively, the optical transmissivity is not less than 1%.

Moreover, in the sintered compact which comprises an aluminum nitride as the main ingredients and whose content of the compound for achieving black-ization containing each element of Mo, W, V, Ti, and Nb is not more than 5 volume % by oxide conversion, respectively, the optical transmissivity is not less than 1%, what was obtained in practice was what has the optical transmissivity at least not less than 10%.

Moreover, in the sintered compact which comprises an aluminum nitride as the main ingredients and contains the unescapable impurities ingredient containing each element of Fe and nickel not more than 1 weight % by oxide conversion, respectively, the optical transmissivity is not less than 1%, what was obtained in practice was what has the optical transmissivity at least not less than 20%.

Moreover, in the thing whose oxygen content of the sintered compact which comprises an aluminum nitride as the main ingredients is not more than 10 weight %, the optical transmissivity is not less than 1%, what was obtained in practice was what has the optical transmissivity at least not less than 20%.

Moreover, in that whose ALON content of the sintered compact which comprises an aluminum nitride as the main ingredients is not more than 20%, the optical transmissivity was not less than 1%.

In the sintered compact which comprises an aluminum nitride as the main ingredients and was produced in this Example, what has the optical transmissivity not less than 50%-60% was also obtained by normal pressure sintering.

Moreover, the thing whose optical transmissivity is 81% was obtained by hotpress firing.

In Table 52, AlN content of all the sintered compacts which comprise an aluminum nitride as the main ingredients other than the sintered compact of experiment No. 6 which comprises an aluminum nitride as the main ingredients is not less than 50%, and it is the optical transmissivity not less than 1%.

In Table 52, the relative density of all the sintered compacts which comprise an aluminum nitride as the main ingredients is not less than 95%, the optical transmissivity is not less than 1% except for the sintered compact of experiment No. 6 which comprises an aluminum nitride as the main ingredients.

In Table 52, the average diameter of an pore of all the sintered compacts which comprise an aluminum nitride as the main ingredients is not more than 1 μm, the optical transmissivity is not less than 1% except for the sintered compact of experiment No. 6 which comprises an aluminum nitride as the main ingredients.

In Table 52, average size of an AlN particle of all the sintered compacts which comprise an aluminum nitride as the main ingredients is not less than 1 μm, the optical transmissivity is not less than 1% except for the sintered compact of experiment No. 6 which comprises an aluminum nitride as the main ingredients.

In Table 52, 5Y₂O₃.3Al₂O₃ is in the sintered compact of experiment No. 8-10 which comprises an aluminum nitride as the main ingredients, 5Y₂O₃.3Al₂O₃ and YAlO₃ are detected other than AlN in No. 13, YAlO₃ and 2Y₂O₃.Al₂O₃ are detected other than AlN in No. 15, 2Y₂O₃.Al₂O₃ and Y₂O₃ are detected other than AlN in No. 16-18, by X ray diffraction.

Moreover, 2Gd₂O₃.Al₂O₃ and Gd₂O₃ are detected in the sintered compact which comprises an aluminum nitride as the main ingredients other than experiment No. 19 AlN by the X ray diffraction.

Moreover, DyAlO₃, and 2Dy₂O₃.Al₂O₃ are detected in the sintered compact of experiment No. 20 which comprises an aluminum nitride as the main ingredients other than AlN by an X ray diffraction.

Moreover, HoAlO₃, and 2Ho₂O₃.Al₂O₃ are detected in the sintered compact of experiment No. 21 which comprises an aluminum nitride as the main ingredients other than AlN by an X ray diffraction.

Moreover, 5Er₂O₃.3Al₂O₃ is detected in the sintered compact of experiment No. 22 which comprises an aluminum nitride as the main ingredients other than AlN by an X ray diffraction.

Moreover, ErAlO₃, and 2Er₂O₃.Al₂O₃ are detected in the sintered compact of experiment No. 23 which comprises an aluminum nitride as the main ingredients other than AlN by an X ray diffraction.

Moreover, 2Er₂O₃.Al₂O₃, and Er₂O₃ are detected in the sintered compact of experiment No. 24 which comprises an aluminum nitride as the main ingredients other than AlN by an X ray diffraction.

Moreover, 5Yb₂O₃.3Al₂O₃, and YbAlO₃ are detected in the sintered compact of experiment No. 25 which comprises an aluminum nitride as the main ingredients other than AlN by an X ray diffraction.

Moreover, the compound considered to be 3CaO.Al₂O₃ and CaO.Al₂O₃ are detected in the sintered compact of experiment No. 14 which comprises an aluminum nitride as the main ingredients other than AlN by an X ray diffraction.

In this Example, the 10 mm×10 mm×0.5 mm substrate for light emitting device mounting is produced as mentioned above by using each sintered compact which comprises an aluminum nitride as the main ingredients other than experiment No. 6, and a commercial light emitting device is mounted, then 3.5 V×350 mA electric power was made to impress to this light emitting element and emit light and the penetration state from a substrate was confirmed with the naked eye, the light which penetrated the substrate was observed in all the produced substrates for light emitting device mounting.

In this case, in this above-mentioned penetration light, most reduction of the brightness by the thin film electric circuit formed on the substrate surface which consists of a sintered compact which comprises an aluminum nitride as the main ingredients was not observed.

In order to compare, the commercial glass plate whose optical transmissivity is 80% is processed into the substrate of a 10 mm×10 mm×0.5 mm size, the penetration light from this glass substrate was observed by mounting the same light emitting element and making it emit light.

As a result, since it is clearly the going-straight light from a light emitting device, brightness which pierces an eye is observed with the naked eye.

On the other hand, when the substrate which used the sintered compact of experiment No. 9 according to this invention which comprises an aluminum nitride as the main ingredients and whose optical transmissivity is 81% is used, in spite of having been the almost same transmissivity, the light which penetrated the substrate was gentle and was that which seldom feels brightness which pierces an eye.

As for what used the sintered compact of optical permeability which comprises an aluminum nitride as the main ingredients and was obtained in this Example as a substrate for light emitting device mounting, all the lights which penetrated this substrate was gentle and was that which seldom feels brightness which pierces an eye.

Moreover, the sintered compact of optical permeability which comprises an aluminum nitride as the main ingredients and was produced in experiment No. 29-36 was presented in color of black, ashes black, and gray.

In what used this sintered compact which colored in black, ashes black, and gray as a substrate for light emitting element mounting, although the light which penetrated this substrate was a gentle thing which seldom feels brightness which pierces an eye, the optical tone delicately differs from the penetration light from the substrate using the sintered compact of optical permeability which comprises an aluminum nitride as the main ingredients and was produced in experiment No. 1-5 and experiment No. 7-28, it was observed so that it might be what has gentleness more.

### EXAMPLE 37

High purity aluminum nitride powder (grade “H” by Tokuyama Soda Co., Ltd. (present: Tokuyama, Inc.)) was prepared as raw powder for sintered compact production which comprises an aluminum nitride as the main ingredients.

This materials powder is manufactured by the oxide reduction method.

This raw powder contains oxygen 1.0 weight % as impurities.

After mixing what added Y₂O₃ powder 3.3 volume % to this raw powder suitably, what added Er₂O₃ powder 4.02 volume %, and what added CaCO₃ powder 0.6 volume % by CaO conversion with toluene and iso propyl alcohol for 24 hours by a ball mill, 12 weight parts of an acrylics binder were added to raw powders of 100 weight parts and they were made into paste by mixing for 12 hours, the green sheet which has three kinds of composition with a thickness of 0.75 mm by the doctor blade method was produced.

Moreover, the green sheet with a thickness of 0.3 mm which consists of the above-mentioned three kinds of composition was also produced independently.

The sheets of the square shape whose one-side is 35 mm were produced from a green sheet with a thickness of 0.75 mm among the above-mentioned green sheets, the circular through hole of the diameter of 25 μm, 50 μm, and 250 μm which penetrates the surface and the back by the punching machine and YAG laser was formed on this sheet.

Next, the pastes for conduction via were produced by adding an alpha terpineol as a solvent and an acrylic resin as a binder, and using three kinds of powder of pure tungsten, the mixed powder of 50 volume % tungsten+50 volume % copper, and pure copper powder, and they were filled up in the above-mentioned through hole.

Lamination and adhesion of the green sheets with a thickness of 0.3 mm was carried out at both sides to the green sheets filled up with the paste for conduction via containing copper.

A green sheets with a thickness of 0.3 mm which carried out lamination and adhesion at both sides is a thing with the state which carried out green sheet fabrication where the through hole etc. is not formed.

In this Example, although having stuck the green sheet to both sides is what considered that the vaporization of copper may not arise during firing, it does not necessarily need according to the case.

They dries after that, after suitably performing a de-binder in the atmosphere which comprises as the main ingredients nitrogen or nitrogen/carbon dioxide mixed gas, co-firing is carried out in normal pressure pure nitrogen atmosphere at 1820 degrees C. for 2 hours in N₂, and the sintered compacts which comprise an aluminum nitride as the main ingredients and whose conduction via was formed in the inside were obtained.

On the occasion of the firing, it was carried out like the method shown in Example 36, that is, the degreasing things of the green sheets which are a fired thing and whose through holes were filled up with conduction via paste were put on the setter made from tungsten, apart from this fired thing, the aluminum nitride powder compact was placed simultaneously, and the circumference was surrounded by the frame of tungsten.

In this sintered compact which comprises an aluminum nitride as the main ingredients, the metal ingredient which was filled up in the through hole of a green sheet at first was enough made densification by sintering or melting and solidification, and conductivity has generated, it unites also with the sintered compact which comprises an aluminum nitride as the main ingredients tight, and is functioning as a conduction via.

A reaction is not recognized between these sintered compacts which comprise an aluminum nitride as the main ingredients and each conduction via material of tungsten, 50 volume % tungsten +50 volume % copper, and copper.

The size of the obtained conduction via has shrunk after firing and has become the diameter of 208-216 μm, 40-44 μm, and 20-23 μm, respectively, in the inside of the sintered compact which comprises an aluminum nitride as the main ingredients.

Next, an internal conduction via was exposed by grinding the both sides of the obtained sintered compact to the size with a diameter of 25.4 mm×thickness of 0.5 mm, and carrying out specular surface polish processing, and the substrate-like sintered compacts which comprise an aluminum nitride as the main ingredients and have a conduction via was produced.

The surface smooth nature after specular surface polish was about average surface roughness (Ra)=26 nm.

In addition, the above-mentioned conduction via is alloted so that 1-30 pieces may be formed in 10 mm×10 mm area.

The optical transmissivity to monochromatic light with a wavelength 605 nm is measured using the sintered compacts which comprise an aluminum nitride as the main ingredients and which were obtained like this and have a conduction via, the resistance in the room temperature of a conduction via was measured by 4 terminal method after that, and the electric resistivity in room temperature was computed from the form of a conduction via.

Consequently, optical transmissivity was not less than 1% also in all the sintered compacts which comprise an aluminum nitride as the main ingredients and formed a conduction via, and what was obtained in practice was what has the optical transmissivity at least not less than 50%.

The electric resistivity in room temperature of a conduction via was the range of 2.0×10⁻⁶ Ω·cm-7.7×10⁻⁶ Ω·cm.

These results are shown in Table 53.

Next, in this Example, the obtained sintered compacts which comprise an aluminum nitride as the main ingredients and which were ground to the size with a diameter of 25.4 mm×thickness of 0.5 mm and carried out specular surface polish processing and have the conduction via are cut in a 10 mm×10 mm size, respectively, the electric circuit with a width of 50 μm for this light emitting device drive was formed on one side by the Ti/Pt/Au thin film, and the substrates for light emitting device mounting were produced.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

Consequently, the light which penetrated the substrate was observed in all the produced substrates for light emitting device mounting.

This penetration light was gentle and bright.

Moreover, in this penetration light, the shadow of the conduction via formed in the substrate which consists of the sintered compact which comprises an aluminum nitride as the main ingredients was not observed also in all the substrates which have a conduction via of the quantity of 1-30.

Moreover, in this above-mentioned penetration light, most reduction of the brightness by the thin film electric circuit formed on the substrate surface which consists of a sintered compact which comprises an aluminum nitride as the main ingredients was not observed.

In addition, the thermal conductivity of the sintered compacts which comprise an aluminum nitride as the main ingredients and which were obtained in this Example and was produced in experiment No.37-51 was in the range of 150 W/mK-180 W/mK altogether in room temperature.

### EXAMPLE 38

As the raw powder for sintered compact production which comprises an aluminum nitride as the main ingredients, two kinds of aluminum nitride powder (“TOYALNITE” by Toyo Aluminium K. K. and “Grade B” by Starck Co. of Germany) produced by the direct nitriding method of metal aluminum was prepared other than two kinds of the raw materials used in Example 36 and the Example 37 by the reduction method of an aluminum oxide. Among these materials, molding and degreasing by the same method as Example 36 were performed by using two kinds of raw material powders produced by the direct nitriding method of aluminum metal respectively alone, and by using what mixed respectively 50 weight % of the raw materials produced by the method of an aluminum oxide reduction and by the direct nitriding method of aluminum metal, then six kinds of sintered compacts which comprise an aluminum nitride as the main ingredients were obtained by performing a hotpress under 300 Kg/cm² at 1950 degree C. for 2 hours in nitrogen.

The obtained sintered compacts were ground to a size with a diameter of 25.4 mm×thickness of 0.5 mm and carried out specular surface polish processing, and the substrates which consist of a sintered compact which comprises an aluminum nitride as the main ingredients and have the degree of surface smoothness Ra=27 nm were produced.

In the sintered compact which used only “TOYALNITE” as a raw material, it is detected by X ray diffraction that the main phase is AlN and that the other is ALON of 1.6%.

Moreover, in the sintered compact which used only “Grade B” as a raw material, it is detected that the main phase is AlN and that the other is ALON of 2.2%.

Moreover, also in the sintered compact which was produced from the mixed raw material between the thing by the reduction method of an aluminum oxide and the raw material produced by the direct nitriding method of aluminum metal, similarly, the main phase is AlN and it contains ALON 1.2-1.9%.

All of the relative density of these six kinds of sintered compacts are not less than 98%.

The optical transmissivity to monochromatic light with a wavelength 605 nm was measured using the above-mentioned substrate on which specular surface polish processing was carried out.

Consequently, as for the optical transmissivity of two kinds of sintered compacts produced only using the raw material by the direct nitriding method of metal aluminum, what used “TOYALNITE” is 69%, and what used “Grade B” is 53%, what used which raw material also showed optical transmissivity not less than 50%.

On the other hand, as for the optical transmissivity of two kinds of sintered compacts produced only using the raw material produced by the reduction method of an oxide, what used the “H” grade is 59%, and what used the “F” grade is 70%, what used which raw material also showed optical transmissivity not less than 50%.

Furthermore, in the sintered compact produced from the raw material which mixed the raw material by the direct nitriding method of metal aluminum, and the raw material produced by the reduction method of an oxide by a unit of 50 weight %, the optical transmissivity of the sintered compact obtained from the mixed raw material powder of a “TOYALNITE”+“H” grade is 58%, and what used a “TOYALNITE”+“F” grade is 67%, what used which raw material also showed optical transmissivity not less than 50%.

The 10 mm×10 mm×0.5 mm substrate on which specular surface polish was carried out is cut down, respectively, from the above-mentioned six kinds of sintered compact which comprises an aluminum nitride as the main ingredients, the electric circuit with a width of 50 μm for this light emitting device drive was formed on one side by the Ti/Pt/Au thin film, and the substrates for light emitting device mounting were produced.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

Consequently, the light which penetrated the substrate was observed in all the produced substrates for light emitting device mounting.

This penetration light was gentle and bright.

Moreover, in this above-mentioned penetration light, most reduction of the brightness by the thin film electric circuit formed on the substrate surface which consists of a sintered compact which comprises an aluminum nitride as the main ingredients was not observed.

In addition, the thermal conductivity of the six kinds of sintered compacts which comprise an aluminum nitride as the main ingredients and were obtained in this Example was is in the range of 76 W/mK-87 W/mK in room temperature.

### EXAMPLE 39

11 kinds of the sintered compacts which comprise an aluminum nitride as the main ingredients by the same method as embodiment 36 was newly produced, and the characteristic of these sintered compacts was investigated by the same method as embodiment 36.

All the optical transmissivity of the sintered compacts which comprise an aluminum nitride as the main ingredients and were obtained according to this Example is not less than 1%, and all the actually obtained things had optical transmissivity not less than 30%.

The measurement result of the characteristic of sintered compacts is shown in Table 54.

In addition, although not described in Table 54, the surface smooth nature after specular surface polish suited the range of average surface roughness (Ra)=26 nm-32 nm.

All the optical transmissivity measured by monochromatic light with a wavelength 605 nm was not less than 30% range.

Moreover, the optical transmissivity of all the things that added a rare earth element compound, a calcium compound, and alumina, and were produced was not less than 50%.

The 10 mm×10 mm×0.5 mm substrate on which specular surface polish was carried out was cut down from the above-mentioned 11 kinds of the sintered compacts which comprise an aluminum nitride as the main ingredients, respectively, the electric circuit with a width of 50 μm for this light emitting device drive was formed on one side by the Ti/Pt/Au thin film, and the substrates for light emitting device mounting were produced.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

Consequently, the light which penetrated the substrate was observed in all the produced substrates for light emitting device mounting.

This penetration light was gentle and bright.

Moreover, in this above-mentioned penetration light, most reduction of the brightness by the thin film electric circuit formed on the substrate surface which consists of a sintered compact which comprises an aluminum nitride as the main ingredients was not observed.

### EXAMPLE 40

The transmissivity to the light with 300 nm wavelength of the sintered compacts which comprise an aluminum nitride as the main ingredients and were produced in Example 36 and Example 39 was measured.

Except that light was replaced with ultraviolet rays, measurement was performed by the same method as Example 36.

The result is shown in Table 55.

As for this result, it was shown that the transmissivity to the light with a wavelength 300 nm is also not less than 1%.

Moreover, it was shown clearly that the sintered compact which comprises an aluminum nitride as the main ingredients and has high optical transmissivity in a visible light domain has the tendency to have high transmissivity also in ultraviolet light.

Optical transmissivity was as high as a maximum of 72% also to 300 nm ultraviolet light.

### EXAMPLE 41

In this Example, the characteristic of the sintered compact which comprises an aluminum nitride as the main ingredients and was obtained by heating for a long time the beforehand fired sintered compact or the powder compact which comprises an aluminum nitride as the main ingredients was investigated.

As the raw material powder for sintered compact production which comprises an aluminum nitride as the main ingredients, high purity aluminum nitride powder manufactured by the reduction method of an oxide (aluminum oxide) (grade “H” by Tokuyama Soda Co., Ltd. (present: Tokuyama, Inc.)) and “TOYALNITE” by Toyo Aluminium K.K. produced by the direct nitriding method of metal aluminum were prepared, various rare earth element compound and alkaline-earth-metals compound powders were prepared as sintering aids.

As a result of analysis, oxygen is contained in the “H” grade 1.2 weight % and in the “TOYALNITE” 1.4 weight % as impurities.

Mean particle diameters of the powder are 0.9 μm and 1.1 μm, respectively.

Moreover, in addition to this, an aluminum oxide, carbon, silicon, etc. were prepared as an additive.

The powder compact of various compositions was produced by the same method as Example 36 using these raw materials.

Moreover, normal pressure sintering was carried out at 1800 degrees C. for 1 hour by the same method as Example 36 so that sintering aids etc. may not vaporize as much as possible using a part of powder compacts which were obtained in this way, and the beforehand fired sintered compacts were also produced.

As for these beforehand fired sintered compacts, the sample of experiment No.118-121 of the table 57 showing the contents of this Example is it.

After the powder compact and the beforehand fired sintered compact which were obtained as mentioned above were put on the setter made from carbon, they were put into the saggar made from carbon, and they were fired at high temperature for a long time under the condition of various temperature and time in the nitrogen atmosphere of the normal pressure including carbon monoxide 1000 ppm using a carbon furnace, the sintered compacts which comprise an aluminum nitride as the main ingredients were obtained.

As for the obtained sintered compact, the chemical composition analysis, the fixed quantity of AlN crystal phase by an X ray diffraction, and the measurement of an aluminum nitride particle size were performed.

As for the fixed quantity of the AlN crystal phase by an X ray diffraction, it is the value calculated by deducting the quantity of crystal phases other than this AlN from the quantity of the whole crystal phase, after the diffraction peak of crystal phases other than AlN was measured and the ratio of it and the strongest diffraction peak of AlN was asked for in percentage.

Next, the surface of the obtained sintered compact was polished to 30 nm in the state of specular surface and was processed to the thickness of 0.5 mm, and optical transmissivity was measured by the monochromatic light with a wavelength 605 nm.

These results are shown in Table 56 and Table 57.

The composition and firing condition of the powder compacts for sintered compact production which comprise an aluminum nitride as the main ingredients and were produced by using the raw material by the oxide reduction method, and the composition and characteristic of the obtained sintered compacts are described in Table 56.

The composition and firing condition of the powder compacts for sintered compact production which comprise an aluminum nitride as the main ingredients and were produced by using the raw material by by the direct nitriding method of metal aluminum, and the composition and characteristic of the obtained sintered compacts are described in Table 57.

Moreover, as a sample which is fired for a long time, the example of the sintered compact after the prolonged firing which was produced by using the beforehand fired sintered compact is also shown in Table 57 (Experiment No. 118-121).

All the optical transmissivity of the sintered compact which comprises an aluminum nitride as the main ingredients and was obtained in this Example was not less than 1%.

The sintered compact which comprises an aluminum nitride as the main ingredients and which raised AlN purity was obtained by the above-mentioned method of firing for a comparatively long time not less than 3 hours at the temperature not less than 1750 degrees C., and the optical transmissivity of these sintered compacts was not less than 40%.

In the powder compact or the beforehand fired sintered compact which contain a rare earth element compound and an alkaline-earth-metals compound as sintering aids, there is a tendency to be easy to increase the purity of AlN of this sintered compact which comprises an aluminum nitride as the main ingredients, when ingredients, such as sintering aids, are vaporized and removed at a lower temperature in short time.

Moreover, in the powder compact or the beforehand fired sintered compact which contain simultaneously a rare earth element compound and an alkaline-earth-metals compound, there is a tendency to be easy to increase the purity of AlN of this sintered compact which comprises an aluminum nitride as the main ingredients, when ingredients, such as sintering aids, are vaporized and removed at a still lower temperature in short time.

Consequently, even if it is the powder compact which does not contain ingredients, such as sintering aids, such as a rare earth element compound and an alkaline-earth-metals compound, or Si, Mo, C (carbon), Fe, nickel, by firing at high temperature for a long time, the size of an aluminum nitride particle increases and the sintered compact which comprises an aluminum nitride as the main ingredients and whose rare earth element compound and an alkaline-earth-metals compound were vaporized and removed is obtained.

The average size of an aluminum nitride particle of these sintered compacts which comprise an aluminum nitride as the main ingredients is not less than 5 μm.

All of the optical transmissivity of these sintered compacts were not less than 40%.

Moreover, in this Example, the size of an aluminum nitride particle increases and the sintered compact which comprises an aluminum nitride as the main ingredients and whose rare earth element compound and an alkaline-earth-metals compound were vaporized and removed is obtained, when the powder compact or the beforehand fired sintered compact which contain a rare earth element compound and an alkaline-earth-metals compound as sintering aids, is fired at high temperature for a long time.

The average size of an aluminum nitride particle of these sintered compacts which comprise an aluminum nitride as the main ingredients is not less than 5 μm, they consisted of the composition wherein the content of at least one or more compounds selected from a rare earth element compound and an alkaline-earth-metals compound is a total of not more than 0.5 weight % by element conversion and the oxygen content is not more than 0.9 weight %.

All of the optical transmissivity of these sintered compacts were not less than 40%.

What has the optical transmissivity of a maximum of 88% in these sintered compacts was obtained.

Moreover, most influences by raw material powder are not seen to optical transmissivity, even if it is which raw material, the sintered compact which comprises an aluminum nitride as the main ingredients and has good optical transmissivity is obtained.

Moreover, the thermal conductivity became high to not less than 200 W/mK in room temperature, and the thing of experiment No. 120 was 237 W/mK.

### COMPARATIVE EXAMPLE

For comparison, although the same powder compact as experiment No. 100 was placed on the setter made from tungsten, was put in the saggar made from tungsten, and was fired at the temperature of 2200 degrees C. for 8 hours in pure nitrogen atmosphere by the tungsten furnace which consists of tungsten furnace material and a heating element, most yttrium oxide which is sintering aids is not vaporized and removed, and remains like as a powder compact, high purification is not attained.

Moreover, thermal conductivity is also as low as not more than 200 W/mK, and optical permeability was also small.

The 10 mm×10 mm×0.5 mm substrate on which specular surface polish was carried out was cut down from the sintered compacts which comprise an aluminum nitride as the main ingredients and were obtained in this Example, respectively, the electric circuit with a width of 50 μm for this light emitting device drive was formed on one side by the Ti/Pt/Au thin film, and the substrates for light emitting device mounting were produced.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

Consequently, the light which penetrated the substrate was observed in all the produced substrates for light emitting device mounting.

This penetration light was gentle and bright.

Moreover, in this above-mentioned penetration light, the shadow by the thin film electric circuit formed on the substrate surface which consists of a sintered compact which comprises an aluminum nitride as the main ingredients was not observed.

### EXAMPLE 42

Using the powder compact produced in Example 41, the powder compact of experiment No. 104 used in Example 41 is used except having replaced with four kinds of the firing atmosphere of nitrogen containing 150 ppm of carbon monoxide, nitrogen containing 60 ppm of hydrogen, nitrogen containing 240 ppm of hydrocarbon, and argon containing 1800 ppm of carbon monoxide, it was fired at the temperature of 2200 degrees C. for 4 hours using the same carbon setter as embodiment 41, the carbon saggar, and the carbon furnace, and the sintered compact which comprises an aluminum nitride as the main ingredients was obtained.

Consequently, in all the things fired in the above-mentioned atmosphere, the content of yttrium and calcium became to not more than 0.5 ppm like Example 41, respectively.

An aluminum nitride particle also has grown up into 30 μm-45 μm, all the optical transmissivity measured in the thickness of 0.5 mm also exceeded 80%.

The 10 mm×10 mm×0.5 mm substrate on which specular surface polish was carried out was cut down from the sintered compacts which comprise an aluminum nitride as the main ingredients and were obtained in this Example, the electric circuit with a width of 50 μm for this light emitting device drive was formed on one side by the Ti/Pt/Au thin film, and the substrates for light emitting device mounting were produced.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

Consequently, the light which penetrated the substrate was observed in all the produced substrates for light emitting device mounting.

This penetration light was gentle and enough bright.

Moreover, in this above-mentioned penetration light, most reduction of the brightness by the thin film electric circuit formed on the substrate surface which consists of a sintered compact which comprises an aluminum nitride as the main ingredients was not observed.

### EXAMPLE 43

High purity aluminum nitride powder (grade “H” by Tokuyama Soda Co., Ltd. (present: Tokuyama, Inc.)) was prepared as raw material powder for sintered compact production which comprises an aluminum nitride as the main ingredients.

This raw material powder is manufactured by the oxide reduction method.

What added Y₂O₃ powder 5 weight % to this raw material powder and what added 5 weight % of Y₂O₃ powder and 0.5 weight % of CaCO₃ powder by CaO conversion were mixed with toluene and iso propyl alcohol by a ball mill for 24 hours, then 12 weight parts of an acrylics binder was added to 100 weight parts of the raw material powder, further it mixed for 12 hours and changed into a paste state, the green sheet which has two kinds of composition with a thickness of 0.8 mm by the doctor blade method was produced.

The sheets with square shape whose one-side is 35 mm were produced from this green sheet, and the circular through holes which have the diameter of 25 μm and 50 μm and which penetrate the surface and the back were formed by YAG laser on this sheet.

Next, alpha terpineol was used as a solvent, the acrylic resin was used as a binder, tungsten powder was used as a conductive ingredient, and further, the above-mentioned aluminum nitride powder was added to this tungsten powder in the range of 0-30 weight %, and mixed them, then the pastes for conduction vias were produced.

The powder paste of each mixture ratio was filled up in the above-mentioned through holes, then it dried, and after the binder was removed suitably in the atmosphere which comprises as the main ingredients nitrogen or mixed gas of nitrogen and carbon dioxide, the sintered compact which comprises an aluminum nitride as the main ingredients and which has a conduction via was produced by co-firing on the following two firing conditions.

Firing conditions are the following two conditions, 1) normal pressure sintering is carried out at 1820 degrees C. for 2 hours in pure N₂ atmosphere, 2) normal pressure sintering is carried out at 2200 degrees C. for 4 hours in the nitrogen atmosphere containing carbon monoxide 200 ppm.

Thus, the sintered compact which comprises an aluminum nitride as the main ingredients and formed the conduction via in the inside was obtained.

In any sintered compact, the conductive ingredient which was filled up in the through hole of a green sheet at first was enough made dense, and conductivity has generated, it is also uniting with the sintered compact which comprises an aluminum nitride as the main ingredients, it is functioning as a conduction via.

In the above-mentioned thing which was fired at 2200 degrees C. for 4 hours, sintering aids were vaporized and the content of yttrium and calcium has become a total of not more than 50 ppm.

Moreover, the aluminum nitride particle is also growing up into 35 μm-45 μm.

The obtained board-like sintered compacts which comprise an aluminum nitride as the main ingredients and which formed the conduction via were ground and polished in specular surface to the thickness of 0.5 mm.

The optical transmissivity of the sintered compacts with a thickness of 0.5 mm which comprise an aluminum nitride as the main ingredients and which have these conduction vias was also not less than 80% when measuring by the monochromatic light of the wavelength 605.

Also in which sintered compact which was obtained by carrying out the firing at 1820 degrees C. for 2 hours and at 2200 degrees C. for 4 hours, the optical transmissivity of the obtained sintered compact which comprises an aluminum nitride as the main ingredients showed the increasing tendency according to the increasing of the aluminum nitride content in tungsten paste for conduction via.

Next, the resistance in the room temperature of a conduction via was measured by 4 terminal method, and the electric resistivity in room temperature was computed from the form of a conduction via.

The size of a conduction via has shrunk after firing and has become the diameter of 40-44 μm and 20-23 μm, respectively.

These results were shown in Table 58.

Although the electric resistivity in room temperature of a conduction via changed with the content of an aluminum nitride, the firing conditions and the diameter of a conduction via, etc., it was the range of 6.8×10⁻⁶ Ω·cm-132×10⁻⁶ Ω·cm.

In addition, the above-mentioned conduction via is alloted so that 1-30 pieces may be formed in 10 mm×10 mm area.

The 10 mm×10 mm×0.5 mm substrate in which specular surface polish was carried out was cut down from the sintered compacts which comprise an aluminum nitride as the main ingredients and which have a conduction via and were obtained in this Example, respectively, the electric circuit with a width of 50 μm for this light emitting device drive was formed on one side by the Ti/Pt/Au thin film, and the substrates for light emitting device mounting were produced.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

Consequently, the light which penetrated the substrate was observed in all the produced substrates for light emitting device mounting.

This penetration light was gentle and bright.

Moreover, as for this penetration light, most reduction of the brightness by the conduction via formed in the substrate which consists of a sintered compact which comprises an aluminum nitride as the main ingredients was not observed in the substrate which has the conduction via of what kind of quantity of 1-30 pieces.

Moreover, in this above-mentioned penetration light, most reduction of the brightness by the thin film electric circuit formed on the substrate surface which consists of a sintered compact which comprises an aluminum nitride as the main ingredients was not also observed.

### EXAMPLE 44

Using a green sheet with a thickness of 0.75 mm which was produced in Example 37 and which comprises an aluminum nitride as the main ingredients and has three kinds of composition, the sheets with square shape whose one-side is 35 mm were produced.

In addition, these green sheets have Y₂O₃ 3.3 volume %, Er₂O₃ 4.02 volume %, and CaCO₃ 0.6 volume % by CaO conversion, as sintering aids, respectively.

Next, the pastes for electric circuit formation were produced by adding an alpha terpineol as a solvent and an acrylic resin as a binder, and using three kinds of powder of pure tungsten, the mixed powder of 50 volume % tungsten+50 volume % copper, and pure copper powder, wiring with a width of 200 μm was screen-printed in a pitch of 1 mm interval on each above-mentioned sheet, these sheets were laminated so that this wiring may become an inside, after drying and degreasing suitably in the atmosphere which comprises as the main ingredients nitrogen or nitrogen/carbon dioxide mixed gas, they were co-fired on the two firing conditions, that is, 1) normal pressure sintering is carried out at 1820 degrees C. for 2 hours in pure N₂ atmosphere, 2) normal pressure sintering is carried out at 2200 degrees C. for 4 hours in the nitrogen atmosphere containing carbon monoxide 200 ppm, and the sintered compacts which comprise an aluminum nitride as the main ingredients and formed the electric circuit in the inside were obtained.

As for the composition of the sintered compact which comprises an aluminum nitride as the main ingredients and which was fired at 1820 degrees C. and obtained, each ingredient of Y₂O₃, CaO, and Er₂O₃ which existed in the large quantity at the time of a green sheet remained in a quantity almost as it is, the oxygen in raw material also remained in a quantity almost as it is.

On the other hand, as for the sintered compact which comprises an aluminum nitride as the main ingredients and which was fired at 2200 degrees C. and obtained, most of each ingredient of Y₂O₃, CaO, and Er₂O₃ which existed in the large quantity at the time of a green sheet was vaporized, the content of Y₂O₃, CaO, and Er₂O₃ was not more than 100 ppm by element conversion of Y, Ca, and Er in the sintered compact obtained from the green sheet of all three kinds of composition.

Moreover, the content of oxygen contained in raw material also decreased and it was not more than 300 ppm altogether.

The aluminum nitride particle was also growing up into 30 μm-45 μm.

The reaction of the conductive ingredient which forms an electric circuit and the sintered compact which comprises an aluminum nitride as the main ingredients is not seen in these sintered compacts.

After that, the sintered compacts which comprise an aluminum nitride as the main ingredients and formed the electric circuit in the inside were ground and polished in specular surface to the thickness of 0.5 mm.

All the optical transmissivity to monochromatic light with a wavelength 605 nm of the sintered compacts with a thickness of 0.5 mm which comprise an aluminum nitride as the main ingredients and which were obtained like this and formed the electric circuit in the inside was not less than 50%.

Among those, all the optical transmissivity of what was fired at 2200 degrees C. for 4 hours was not less than 80%.

Moreover, when the electric resistivity in room temperature of the electric circuit formed in the inside of the sintered compact which comprises an aluminum nitride as the main ingredients was measured using 4 terminal method, it was the range of 2.2×10⁻⁶ Ω·cm-8.6×10⁻⁶ Ω·cm.

These measurement results were shown in Table 59.

The 10 mm×10 mm×0.5 mm substrate in which specular surface polish was carried out was cut down from the sintered compacts which comprise an aluminum nitride as the main ingredients and which have an internal electric circuit and were obtained in this Example, respectively, the electric circuit with a width of 50 μm for a light emitting device drive was formed on one side by the Ti/Pt/Au thin film, and the substrates for light emitting device mounting were produced.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

Consequently, the light which penetrated the substrate was observed in all the produced substrates for light emitting device mounting.

This penetration light was gentle and enough bright.

Moreover, in this penetration light, reduction of the brightness by the electric circuit which was formed by the co-firing in the inside of the substrate which used the sintered compact which comprises an aluminum nitride as the main ingredients was hardly observed also in which substrate.

Moreover, in this above-mentioned penetration light, most reduction of the brightness by the thin film electric circuit formed on the substrate surface which consists of a sintered compact which comprises an aluminum nitride as the main ingredients was not also observed.

### EXAMPLE 45

Using the green sheet with a thickness of 0.75 mm which comprises an aluminum nitride as the main ingredients and was produced in Example 37 and the paste for conduction via, the green sheet in which the conduction via paste was formed in the through hole by the same method as Example 37 was produced.

By using the paste for electric circuit formation produced in Example 44 using this green sheet in which a conduction via paste is formed, the green sheet in which the circuit pattern was formed in the inside was produced laminating by forming a circuit pattern by the same method as Example 44.

This green sheet is dried after that, and after degreasing suitably in the atmosphere which comprises as the main ingredients nitrogen or nitrogen/carbon dioxide mixed gas, they were co-fired on the two firing conditions, that is, 1) normal pressure sintering is carried out at 1820 degrees C. for 2 hours in pure N₂ atmosphere, 2) normal pressure sintering is carried out at 2200 degrees C. for 4 hours in the nitrogen atmosphere containing carbon monoxide 200 ppm, and the sintered compacts which comprise an aluminum nitride as the main ingredients and formed the conduction via and the electric circuit simultaneously in the inside were obtained.

As for the composition of the sintered compact which comprises an aluminum nitride as the main ingredients and which was fired at 1820 degrees C. and obtained, each ingredient of Y₂O₃, CaO, and Er₂O₃ which existed in the large quantity at the time of a green sheet remained in a quantity almost as it is, the oxygen in raw material also remained in a quantity almost as it is.

On the other hand, as for the sintered compact which comprises an aluminum nitride as the main ingredients and which was fired at 2200 degrees C. and obtained, most of each ingredient of Y₂O₃, CaO, and Er₂O₃ which existed in the large quantity at the time of a green sheet was vaporized, the content of Y₂O₃, CaO, and Er₂O₃ was not more than 100 ppm by element conversion of Y, Ca, and Er in the sintered compact obtained from the green sheet of all three kinds of composition.

Moreover, the content of oxygen contained in raw material also decreased and it was not more than 300 ppm altogether.

The aluminum nitride particle was also growing up into 30 μm-45 μm.

The reaction between the conductive ingredient which forms a conduction via and the conductive ingredient which forms an electric circuit, and the sintered compact which comprises an aluminum nitride as the main ingredients is not seen in these sintered compacts.

All the optical transmissivity by monochromatic light with a wavelength 605 nm of the sintered compacts which comprise an aluminum nitride as the main ingredients and which were obtained like this and formed the conduction via and the electric circuit simultaneously in the inside was not less than 50%.

Among those, all the optical transmissivity of what was fired at 2200 degrees C. for 4 hours was not less than 80%.

Next, the 10 mm×10 mm×0.5 mm substrate in which specular surface polish was carried out was cut down from the sintered compacts which comprise an aluminum nitride as the main ingredients and which have a conduction via and an electric circuit simultaneously in the inside and were obtained in this Example, respectively, the electric circuit with a width of 50 μm for a light emitting device drive was formed on one side by the Ti/Pt/Au thin film, and the substrates for light emitting device mounting were produced.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

Consequently, the light which penetrated the substrate was observed in all the produced substrates for light emitting device mounting.

This penetration light was gentle and enough bright.

Moreover, in this penetration light, reduction of the brightness by the conduction via and the electric circuit which were formed by the co-firing in the inside of the substrate which used the sintered compact which comprises an aluminum nitride as the main ingredients was hardly observed also in which substrate.

Moreover, in this above-mentioned penetration light, most reduction of the brightness by the thin film electric circuit formed on the substrate surface which used a sintered compact which comprises an aluminum nitride as the main ingredients was not also observed.

### EXAMPLE 46

The sheets with square shape whose one-side is 35 mm were produced by using the thing with a thickness of 0.3 mm in the green sheets which comprise an aluminum nitride as the main ingredients and were produced in Example 37.

In addition, these green sheets have three kinds of composition which contain Y₂O₃ 3.3 volume %, Er₂O₃ 4.02 volume %, and CaCO₃ 0.6 volume % by CaO conversion, respectively, as sintering aids.

Next, the pastes for electric circuit formation were produced by adding an alpha terpineol as a solvent and an acrylic resin as a binder, and using three kinds of powder of pure tungsten, the mixed powder of 50 volume % tungsten+50 volume % copper, and pure copper powder, wiring with a width of 50 μm was formed in a pitch of 0.5 mm interval on each above-mentioned sheet, these two sheets are laminated so that this wiring may be formed in an inside and on the surface, after drying and degreasing suitably in the atmosphere which comprises as the main ingredients nitrogen or nitrogen/carbon dioxide mixed gas, they were co-fired on the two firing conditions, that is, 1) normal pressure sintering is carried out at 1820 degrees C. for 2 hours in pure N₂ atmosphere, 2) normal pressure sintering is carried out at 2200 degrees C. for 4 hours in the nitrogen atmosphere containing carbon monoxide 200 ppm, the sintered compacts with a thickness of 0.5 mm which comprises an aluminum nitride as the main ingredients and formed the electric circuit in an inside and on the surface were obtained.

As for the composition of the sintered compact which comprises an aluminum nitride as the main ingredients and which was fired at 1820 degrees C. and obtained, each ingredient of Y₂O₃, CaO, and Er₂O₃ which existed in the large quantity at the time of a green sheet remained in a quantity almost as it is, the oxygen in raw material also remained in a quantity almost as it is.

On the other hand, as for the sintered compact which comprises an aluminum nitride as the main ingredients and which was fired at 2200 degrees C. and obtained, most of each ingredient of Y₂O₃, CaO, and Er₂O₃ which existed in the large quantity at the time of a green sheet was vaporized, the content of Y₂O₃, CaO, and Er₂O₃ was not more than 100 ppm by element conversion of Y, Ca, and Er in the sintered compact obtained from the green sheet of all three kinds of composition.

Moreover, the content of oxygen contained in raw material also decreased and it was not more than 300 ppm altogether.

The aluminum nitride particle was also growing up into 30 μm-45 μm.

The reaction of the conductive ingredient which forms an electric circuit and the sintered compact which comprises an aluminum nitride as the main ingredients is not seen in these sintered compacts.

All the optical transmissivity to monochromatic light with a wavelength 605 nm of the sintered compacts with a thickness of 0.5 mm which comprise an aluminum nitride as the main ingredients and which were obtained like this and formed the electric circuit in the inside was not less than 50%.

Among those, all the optical transmissivity of what was fired at 2200 degrees C. for 4 hours was not less than 80%.

Next, the 10 mm×10 mm×0.5 mm substrate was cut down from the sintered compacts which comprise an aluminum nitride as the main ingredients and which have the internal electric circuit and were obtained in this Example, Ni/Au plating was given to the surface circuit pattern, the electric circuit for a light emitting device drive was formed, and the substrate for light emitting device mounting was produced.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

Consequently, the light which penetrated the substrate was observed in all the produced substrates for light emitting device mounting.

This penetration light was gentle and enough bright.

Moreover, in this penetration light, reduction of the brightness by the electric circuit which was formed by the co-firing in the inside and surface of the substrate which used the sintered compact which comprises an aluminum nitride as the main ingredients was hardly observed also in which substrate.

### EXAMPLE 47

The sheets with square shape whose one-side is 35 mm were produced by using the thing with a thickness of 0.3 mm in the green sheets which comprise an aluminum nitride as the main ingredients and were produced in Example 37.

In addition, these green sheets have three kinds of composition which contain Y₂O₃ 3.3 volume %, Er₂O₃ 4.02 volume %, and CaCO₃ 0.6 volume % by CaO conversion, respectively, as sintering aids.

Using the above-mentioned green sheets which comprise an aluminum nitride as the main ingredients, and the pastes for conduction via, the green sheets in which a conduction via paste was formed in the through hole were produced by the same method as Example 37.

By using the pastes for electric circuit formation produced in Example 44 using these green sheets in which a conduction via paste is being formed, these two green sheets are laminated after forming a circuit pattern by the same method as Example 44, then the green sheets in which the circuit pattern was formed in an inside and on the surface were produced.

These green sheets were dried after that, after degreasing suitably in the atmosphere which comprises as the main ingredients nitrogen or nitrogen/carbon dioxide mixed gas, they were co-fired on the two firing conditions, that is, 1) normal pressure sintering is carried out at 1820 degrees C. for 2 hours in pure N₂ atmosphere, 2) normal pressure sintering is carried out at 2200 degrees C. for 4 hours in the nitrogen atmosphere containing carbon monoxide 200 ppm, the sintered compacts with a thickness of 0.5 mm which comprise an aluminum nitride as the main ingredients and formed the conduction via and the electric circuit simultaneously in the inside were obtained.

As for the composition of the sintered compact which comprises an aluminum nitride as the main ingredients and which was fired at 1820 degrees C. and obtained, each ingredient of Y₂O₃, CaO, and Er₂O₃ which existed in the large quantity at the time of a green sheet remained in a quantity almost as it is, the oxygen in raw material also remained in a quantity almost as it is.

On the other hand, as for the sintered compact which comprises an aluminum nitride as the main ingredients and which was fired at 2200 degrees C. and obtained, most of each ingredient of Y₂O₃, CaO, and Er₂O₃ which existed in the large quantity at the time of a green sheet was vaporized, the content of Y₂O₃, CaO, and Er₂O₃ was not more than 100 ppm by element conversion of Y, Ca, and Er in the sintered compact obtained from the green sheet of all three kinds of composition.

Moreover, the content of oxygen contained in raw material also decreased and it was not more than 300 ppm altogether.

The aluminum nitride particle was also growing up into 30 μm- 45 μm.

The reaction between the conductive ingredient which forms a conduction via and the conductive ingredient which forms an electric circuit, and the sintered compact which comprises an aluminum nitride as the main ingredients is not seen in these sintered compacts.

All the optical transmissivity by monochromatic light with a wavelength 605 nm of the sintered compacts which comprise an aluminum nitride as the main ingredients and which were obtained like this and formed the conduction via and the electric circuit simultaneously in the inside was not less than 50%.

Among those, all the optical transmissivity of what was fired at 2200 degrees C. for 4 hours was not less than 80%.

Next, the 10 mm×10 mm×0.5 mm substrate was cut down from the sintered compacts which comprise an aluminum nitride as the main ingredients and which have a conduction via and an electric circuit simultaneously in the inside and were obtained in this Example, Ni/Au plating was given to the surface circuit pattern, the electric circuit for a light emitting device drive was formed, and the substrate for light emitting device mounting was produced.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

Consequently, the light which penetrated the substrate was observed in all the produced substrates for light emitting device mounting. This penetration light was gentle and enough bright.

Moreover, in this penetration light, reduction of the brightness by the electric circuit of the inside and surface of the substrate which was formed by co-firing using the sintered compact which comprises an aluminum nitride as the main ingredients, and by the conduction via which is being formed in the inside of a substrate, was hardly observed also in which substrate.

### EXAMPLE 48

The high purity aluminum nitride powder (grade “H” by Tokuyama Soda Co., Ltd. (present: Tokuyama, Inc.)) manufactured by oxide reduction method was prepared.

Using the mixed powder in which a yttrium oxide of 5 weight % is included in this aluminum nitride raw material powder as sintering aids, the powder compacts of the various thickness which made outside size the shape of a disk of a 32 mm diameter were produced.

After degreasing these powder compacts, they was fired at 1800 degrees C. for 2 hours in pure nitrogen atmosphere like Example 36 so that it may not become reduction nature, and the sintered compacts of various thickness which comprise an aluminum nitride as the main ingredients were obtained.

Moreover, on the other hand, the above-mentioned powder compacts were fired at 2200 degrees C. for 8 hours in the nitrogen atmosphere which contains 1000 ppm carbon monoxide by a carbon furnace using the setter made from carbon and the saggar made from carbon like Example 36.

As for the sintered compact which comprises an aluminum nitride as the main ingredients and which was fired at 1800 degrees C. and was obtained, Y₂O₃ ingredient which existed in the large quantity at the time of a powder compact remained in a quantity almost as it is, the oxygen in raw material also remained in a quantity almost as it is.

On the other hand, as for the sintered compact which comprises an aluminum nitride as the main ingredients and which was fired at 2200 degrees C. and was obtained, most of Y₂O₃ ingredient which existed in the large quantity at the time of a powder compact was vaporized in all thickness, the content of Y₂O₃ was not more than 200 ppm by Y element conversion. Moreover, the content of oxygen contained in raw material also decreased and it was not more than 500 ppm altogether.

The aluminum nitride particle was also growing up into 30 μm-45 μm.

Consequently, optical transmissivity in the thickness of 0.5 mm of the sintered compact which comprises an aluminum nitride as the main ingredients and which was fired at 1800 degrees C. and was obtained in pure nitrogen atmosphere was 65%.

In addition, the measured value of optical transmissivity is a thing to monochromatic light with a wavelength of 605 nm.

In this sintered compact, the optical transmissivity of what has a thickness of 5 mm was 1.6%.

Moreover, optical transmissivity is 6% in the case of what has a thickness of 2.5 mm, optical transmissivity is 82% in the case of the thickness of 0.2 mm, and optical transmissivity was 91% in the case of the thickness of 0.05 mm.

On the other hand, the optical transmissivity in the thickness of 0.5 mm of the sintered compact which comprises an aluminum nitride as the main ingredients and which fired at 2200 degrees C. in the nitrogen atmosphere containing 1000 ppm carbon monoxide and obtained was 84%.

The optical transmissivity is 1.9% in what has a thickness of 8 mm of this sintered compact, the optical transmissivity is 7% in what has a thickness of 5.0 mm, the optical transmissivity is 14% in what has a thickness of 2.5 mm, the optical transmissivity is 64% in what has a thickness of 1.0 mm, the optical transmissivity is 83% in what has a thickness of 0.5 mm, the optical transmissivity is 92% in what has a thickness of 0.2 mm, the optical transmissivity is 96% in what has a thickness of 0.05 mm.

Next, The 10 mm×10 mm substrate in which specular surface polish was carried out was cut down from the sintered compacts which comprise an aluminum nitride as the main ingredients and were obtained in this Example, respectively, the electric circuit with a width of 50 μm for this light emitting device drive was formed on one side by the Ti/Pt/Au thin film, and the substrates for light emitting device mounting were produced.

Thickness of the substrate using the sintered compact which comprises an aluminum nitride as the main ingredients and which was fired at 1800 degrees C. in pure nitrogen atmosphere and was obtained was made into 0.05 mm, as the substrate which used the sintered compact which comprises an aluminum nitride as the main ingredients and which was fired at 2200 degrees C. in the nitrogen atmosphere containing 1000 ppm carbon monoxide and was obtained, what is the thickness of 0.2 mm was used.

Any substrate consists of a sintered compact which comprises an aluminum nitride as the main ingredients and has the optical transmissivity not less than 90%.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

Consequently, the light which penetrated the substrate was observed in all the produced substrates for light emitting device mounting.

This penetration light was gentle and bright, although it was changing to that whose optical tone is gentle, it was observed that the light which was emitted from a light emitting device originally may be made to penetrate a substrate in the intensity as it is.

Moreover, in this above-mentioned penetration light, most reduction of the brightness by the thin film electric circuit formed on the substrate surface which consists of a sintered compact which comprises an aluminum nitride as the main ingredients was not also observed.

### EXAMPLE 49

Using the green sheets with the thickness of 0.3 mm which were produced in Example 37 and have three kinds of composition containing Y₂O₃ 3.3 volume %, Er₂O₃ 4.02 volume %, and CaCO₃ 0.6 volume % by CaO conversion, the sheets which laminated two sheets, respectively, and were cut down in the square shape of 35 mm square were prepared.

On the other hand, the green sheets of the thickness of 0.75 mm which have the three above-mentioned kinds of composition were prepared, the sheets which were cut down in the square shape of 35 mm square were prepared in the thickness as it is.

After degreasing these sheets at 550 degrees C. in air, the powder compacts were put on the setter made from an aluminum nitride and were fired at 1800 degrees C. for 2 hours in pure nitrogen atmosphere, and the sintered compacts which comprise an aluminum nitride as the main ingredients were obtained.

The lap grinding and specular surface polish of the sintered compact which was produced from the green sheet with a thickness of 0.75 mm into the thickness of 0.5 mm were carried out, and the reflectance and the optical transmissivity of the surface were measured.

The sintered compact which was produced from the green sheet which laminated two sheets of the thickness of 0.3 mm is the 0.5 mm thickness, the reflectance and the optical transmissivity were measured in the state of the as-fired (as-fire) surface.

Reflectance and optical transmissivity were measured using monochromatic light with a wavelength 605 nm.

Subsequently, the sintered compacts of each above-mentioned surface state which comprise an aluminum nitride as the main ingredients were heated at 1000 degrees C. for 1 hour in air, and the self-oxidization coat was formed on the surface.

The thickness of the formed self-oxidization coat is about 0.3 μm, and consists of an aluminum oxide.

The silica coat with a thickness of 0.4 μm was formed on the sintered compact of each above-mentioned surface state which comprises an aluminum nitride as the main ingredients by the CVD method using ethyl silicate.

The sputter coat of magnesium oxide with a thickness of 0.3 μm was formed on the sintered compact of each above-mentioned surface state which comprises an aluminum nitride as the main ingredients.

The optical transmissivity of the sintered compact which comprises an aluminum nitride as the main ingredients and which has a self-oxidization coat, a silica coat, and a magnesia coat was measured.

These results were shown in Table 60.

As shown in Table 60, the reflectance of the sintered compact which comprises an aluminum nitride as the main ingredients before forming a self-oxidization coat, a silica coat, and a magnesia coat is seldom influenced by composition, it was 9-12% in the case of the as-fired surface (as-fire), it was 13-16% in the case of the specular surface polish surface, it was 10-12% in the case of the lap polish surface.

Moreover, optical transmissivity was 56%-65%.

On the other hand, the optical transmissivity of the sintered compact which comprises an aluminum nitride as the main ingredients after formation of a self-oxidization coat, a silica coat, and a magnesia coat improved about 10%-11% to 67% -76%.

Since a self-oxidization coat, a silica coat, and a magnesia coat are the refractive index not more than 2.3 and the optical permeability is high, it seems that it is the result of functioning as a reflective prevention material.

Next, the sintered compacts before and after forming a self-oxidization coat, a silica coat, and a magnesia coat which comprise an aluminum nitride as the main ingredients and which were obtained in this Example were cut down in a 10 mm×10 mm×0.5 mm size, respectively, the circuit pattern with a width of 100 μm was formed in one side with the thick film paste which comprises Ag/Pd as the main ingredients, the electric circuit for a light emitting device drive was produced, and the substrates for light emitting device mounting were obtained.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

Consequently, the light which penetrated the substrate was observed in all the produced substrates for light emitting device mounting.

This penetration light was gentle and enough bright.

Among them, the penetration light from the substrate which used the sintered compacts after forming a self-oxidization coat, a silica coat, and a magnesia coat which comprise an aluminum nitride as the main ingredients is gentle and brighter, the intensity of penetration light is increasing.

Moreover, in this above-mentioned penetration light, most reduction of the brightness by the thick film electric circuit formed on the substrate surface which used a sintered compact which comprises an aluminum nitride as the main ingredients was not also observed.

### EXAMPLE 50

Using the green sheets with a 35 mm×thickness of 0.75 mm which were produced in Example 49 and which have three kinds of composition containing Y₂O₃ 3.3 volume %, Er₂O₃ 4.02 volume %, and CaCO₃ 0.6 volume % by CaO conversion, after degreasing these sheets at 550 degrees C. in air, normal pressure sintering was carried out by carbon heater furnace at 1800 degrees C. for 2 hours in pure nitrogen atmosphere by using the carbon setter which coated boron nitride, and the sintered compacts which comprise an aluminum nitride as the main ingredients were produced.

The obtained sintered compact which comprises an aluminum nitride as the main ingredients was showing gray—ashes black.

When optical transmissivity was measured, it was 12.7% in what contains Y₂O₃, 8.4% in what contains Er₂O₃, and 0% in what contains CaO.

Next, the vapor deposition coat of aluminum, gold, silver, copper, palladium, and platinum was formed all over one side of the obtained sintered compact which comprises an aluminum nitride as the main ingredients.

Each thickness of this vapor deposition coat is 0.4 μm.

The reflectance and optical transmissivity of the produced sintered compact which comprises an aluminum nitride as the main ingredients and which formed vapor deposition coat was measured.

Reflectance and optical transmissivity were measured using monochromatic light with a wavelength 605 nm.

The optical transmissivity of the sintered compact which comprises an aluminum nitride as the main ingredients and which formed the vapor deposition coat was 0% altogether.

These results were shown in Table 61.

However, the measurement result of optical transmissivity is not shown in Table 61.

As shown in Table 61, each reflectance of the sintered compact which comprises an aluminum nitride as the main ingredients and which formed the vapor deposition coat was as high as not less than 70%.

Especially, the reflectance was not less than 90% in what formed aluminum, gold, silver, and copper on the sintered compact surface which comprises an aluminum nitride as the main ingredients and which carried out specular surface polish.

Next, by using the green sheet produced in Example 37, the substrate for light emitting device mounting which has cavity space (cavity) by the unified sintered compact which comprises an aluminum nitride as the main ingredients was produced.

The substrate for light emitting device mounting which has this cavity space (cavity) is what has a form which is illustrated with the mark 30 in FIG. 74, 76, 78, 82, 83, 84, 88, 89, 91, 92, 93, and 94.

The outside dimension of the substrate for light emitting device mounting which has this cavity space (cavity) is 10 mm×10 mm×2 mm, the substrate thickness of a light emitting device mounting surface and a cavity space side wall is 0.5 mm, respectively.

The electric circuit with a line width of 150 μm for a light emitting device drive is formed on the light emitting device mounting surface of cavity space by the co-firing which used tungsten, and Ni/Au plating is given.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, it pasted up by the epoxy resin and the light emitting device was sealed by using the sintered compact as it is which comprises an aluminum nitride as the main ingredients and which does not form the self-oxidization coat, the silica coat, and the vapor deposition coat etc. which were produced in Example 49 and what has a vapor deposition coat on the whole surface created in this Example as a lid.

After that, 3.5 V×350 mA electric power was impressed to a light emitting device, and it was made to emit light, the penetration state from the substrate of this luminescence was confirmed with the naked eye.

Consequently, in what used the sintered compact which comprises an aluminum nitride as the main ingredients and which does not form the vapor deposition coat and was produced in Example 49 as a lid, luminescence which penetrated the substrate from the whole substrate was observed.

This penetration light was gentle and enough bright.

On the other hand, in what used the sintered compact which comprises an aluminum nitride as the main ingredients and whose vapor deposition coat which was produced in this Example was formed on the whole surface as a lid, although luminescence which penetrated this lid in the lid portion is not observed clearly, luminescence which penetrated the substrate was observed in the substrate surface side which mounts a light emitting device.

Although this penetration light is gentle, the brightness was quite larger than the thing from the substrate which used the lid which does not form the vapor deposition coat.

In addition, in this above-mentioned penetration light, most reduction of the brightness by the electric circuit formed by the co-fired metallizing on the substrate surface which consists of a sintered compact which comprises an aluminum nitride as the main ingredients was not observed.

Thus, in this Example, it was shown that control of the direction of luminescence from a light emitting device and control of the intensity of luminescence are possible.

### EXAMPLE 51

The sintered compact as it is which comprises an aluminum nitride as the main ingredients and which does not form a self-oxidization coat, a silica coat, a magnesia coat, and a vapor deposition coat, etc. of outside dimension 10 mm×10 mm×0.5 mm and was produced in Example 49 was prepared as a base.

Wiring of a thick film metallizing with a line width of 150 μm which comprises Ag/Pd as the main ingredients was formed on this base as an electric circuit for a light emitting device drive.

On the other hand, the frame consisting of high purity aluminum whose outside dimension is 10 mm×10 mm×1.5 mm and whose inside dimension is 7 mm×7 mm×1.5 mm was prepared.

These base and frame correspond to the parts of the mark 34 and a mark 35 illustrated in FIG. 83, respectively.

By pasting up this base and frame by a commercial epoxy resin and silicone resin, the substrate for light emitting device mounting which has cavity space (cavity) as shown in FIG. 83 was obtained.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the base portion of this produced substrate for light emitting device mounting.

Subsequently, the sintered compact which comprises an aluminum nitride as the main ingredients and was produced in Example 50 on which the metal aluminum was vapor-deposited was prepared as a lid, the substrate for light emitting device mounting was pasted by a commercial epoxy resin and silicone resin, and the light emitting device was sealed.

3.5 V×350 mA electric power was impressed after sealing, the light emitting device was made to emit light, and the penetration state from the substrate of this luminescence was confirmed with the naked eye.

Consequently, the light which penetrated the substrate in all the produced substrates for light emitting device mounting was observed.

This penetration light was observed only from the base portion on which the light emitting device in the substrate for light emitting device mounting was mounted.

Although this penetration light was gentle, it was observed more brightly than the penetration light observed in Example 50.

Thus, in this Example, the luminescence direction from a light emitting device could be controlled in the narrower domain, and it was shown that the intensity control of still bigger luminescence on the intensity is possible.

In the substrate base for light emitting device mounting which was produced by joining the base which consists of the above-mentioned sintered compact which comprises an aluminum nitride as the main ingredients and the frame which consists of the high purity aluminum by using an epoxy resin and silicone resin, although investigated about the long-term reliability of this junction portion, it was confirmed that the thing which was joined using silicone resin is very tough against thermal shock, such as rapid heating and cooling.

That is, even if it repeats not less than 3000 cycles of cold thermal shock tests for −40 degrees C.−+125 degrees C., it is hard to produce faults, such as a crack, into a junction portion, and adhesion strength cannot fall easily, either.

Even if this is junction of the above-mentioned material with the large difference of coefficient-of-thermal-expansion between the sintered compact which comprises an aluminum nitride as the main ingredients and the high purity aluminum, since the softness whose silicone resin has may tend to absorb the stress resulting from this difference of coefficient-of-thermal-expansion, it seems that the reliability of junction becomes high.

Therefore, as for the substrate for light emitting device mounting produced using silicone resin for junction between a base and a frame, it is optimal for the use which mounts the light emitting device to which big power is added intermittently repeatedly.

### EXAMPLE 52

High purity aluminum nitride powder (grade “H” by Tokuyama Soda Co., Ltd. (present: Tokuyama, Inc.)) was prepared as raw material powder for sintered compact production which comprises an aluminum nitride as the main ingredients.

This raw material powder is manufactured by the oxide reduction method.

What added Y₂O₃ powder 5 weight % to this raw material powder, what added 5 weight % of Y₂O₃ powder and 0.5 weight % of CaCO₃ powder by CaO conversion, what added 9 weight % of Er₂O₃ powder, and what added 3 weight % of Er₂O₃ powder and 0.5 weight % of CaCO₃ powder by CaO conversion were mixed with toluene and iso propyl alcohol by a ball mill for 24 hours, then 12 weight parts of an acrylics binder was added to 100 weight parts of the raw material powder, further it mixed for 12 hours and changed into a paste state, the green sheet which has four kinds of composition with a thickness of 0.3 mm by the doctor blade method was produced.

The sheets with square shape whose one-side is 35 mm were produced by using the obtained green sheet of four kinds of composition with a thickness of 0.3 mm which comprises an aluminum nitride as the main ingredients.

The circular through hole with a diameter of 150 μm which penetrates the surface and the back by a punching machine on these sheets was formed.

Next, An alpha terpineol was added as a solvent and an acrylic resin was added as a binder, using tungsten powder as a conductive ingredient, and further, the above-mentioned aluminum nitride powder was added to this tungsten powder in the range of 0-30 weight %, it mixed and the paste for conduction vias was produced, it was filled up in the above-mentioned through hole.

Moreover, like the paste for conduction via, the alpha terpineol was used as a solvent and the acrylic resin was used as a binder, using tungsten powder as a conductive ingredient, and further, the above-mentioned aluminum nitride powder was added to this tungsten powder in the range of 0-30 weight %, it mixed and the paste for electric circuits was produced.

Next, wiring with a width of 150 μm was screen-printed in a pitch 0.6 mm interval with the paste for electric circuits on each sheet which was filled up with the above-mentioned paste for conduction vias, these two sheets were laminated so that this wiring might be formed in an inside and the surface.

The plate-like pattern of 1.5 mm square is being formed on the surface of one side of this green sheet lamination object with the paste for electric circuits.

In addition, when the above-mentioned green sheet lamination object is produced, the tungsten and the aluminum nitride which are the conductive ingredient contained in the paste for conduction vias and the paste for electric circuits used what becomes the same composition.

After drying the acquired green sheet lamination objects and degreasing suitably in the atmosphere which comprises as the main ingredients nitrogen or nitrogen/carbon dioxide mixed gas, they were co-fired on the two firing conditions, that is, 1) normal pressure sintering is carried out at 1820 degrees C. for 2 hours in pure N₂ atmosphere, 2) normal pressure sintering is carried out at 2200 degrees C. for 4 hours in the nitrogen atmosphere containing carbon monoxide 200 ppm, the sintered compacts with a thickness of 0.5 mm which comprise an aluminum nitride as the main ingredients and which formed the electric circuit in an inside and on the surface and formed furthermore the conduction via in the inside were obtained.

As for the composition of the sintered compact which comprises an aluminum nitride as the main ingredients and which was fired at 1820 degrees C. and obtained, each ingredient of Y₂O₃, CaO, and Er₂O₃ which existed in the large quantity at the time of a green sheet remained in a quantity almost as it is, the oxygen in raw material also remained in a quantity almost as it is.

On the other hand, as for the sintered compact which comprises an aluminum nitride as the main ingredients and which was fired at 2200 degrees C. and obtained, most of each ingredient of Y₂O₃, CaO, and Er₂O₃ which existed in the large quantity at the time of a green sheet was vaporized, the content of Y₂O₃, CaO, and Er₂O₃ was not more than 100 ppm by element conversion of Y, Ca, and Er in the sintered compact obtained from the green sheet of all four kinds of composition.

Moreover, the content of oxygen contained in raw material also decreased and it was not more than 300 ppm altogether.

The aluminum nitride particle was also growing up into 30 μm-45 μm.

Also in the sintered compact which was obtained by firing at 1820 degrees C. for two hours and at 2200 degrees C. for four hours, the optical transmissivity of the sintered compact which comprises an aluminum nitride as the main ingredients showed the increasing tendency according to the increase of the aluminum nitride content in tungsten paste for electric circuits.

In these sintered compacts, the reaction between the sintered compact which comprises an aluminum nitride as the main ingredients and the conductive ingredient which forms an electric circuit and the ingredient which forms a conduction via is not seen.

Thus, as for the optical transmissivity to monochromatic light with a wavelength 605 nm of the obtained sintered compacts with a thickness of 0.5 mm which comprise an aluminum nitride as the main ingredients and which formed the electric circuit in an inside and on the surface and formed furthermore the conduction via in the inside, it was not less than 50% altogether.

Among those, all the optical transmissivity of what was fired at 2200 degrees C. for 4 hours was not less than 80%.

Moreover, when the electric resistivity in room temperature of the electric circuit formed in the inside of the sintered compact which comprises an aluminum nitride as the main ingredients was measured using 4 terminal method, it was the range of 6.9×10⁻⁶ Ω·cm-166×10⁻⁶ Ω·cm.

The measurement result of the above-mentioned optical transmissivity and electric resistivity was shown in Table 62.

Next, the 10 mm×10 mm×0.5 mm substrate was cut down from the sintered compacts of four kinds of composition which comprise an aluminum nitride as the main ingredients and which have an electric circuit in the inside and on the surface and a conduction via further in the inside and were obtained in this Example, the electric circuit for a light emitting device drive was formed by giving Ni/Au plating to a surface circuit pattern and a surface plate-like pattern, the same substrate for light emitting device mounting as what was illustrated in FIG. 100 was produced.

The commercial light emitting device of 1 mm square which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on each produced substrate by adhering by using the low melting point braze material which comprises Sn as the main ingredients, 3.5 V×350 mA electric power is impressed, and is made to emit light, then the penetration state from the substrate of this luminescence was confirmed with the naked eye.

Consequently, the light which penetrated the substrate was observed in all the produced substrates for light emitting device mounting.

This penetration light was gentle and enough bright.

Moreover, in this penetration light, reduction of the brightness by the electric circuit which was formed by the co-firing in the inside and surface of the substrate which used the sintered compact which comprises an aluminum nitride as the main ingredients was hardly observed also in which substrate.

### EXAMPLE 53

What cut the green sheets which have four kinds of different composition produced in Example 52 in the size of 100 mm square, respectively were prepared, the above-mentioned green sheets were processed so that it might become the form of the substrate for light emitting device mounting of having a cavity space which has an electric circuit in an inside and on the surface and whose conduction via is formed in an inside by further using the paste for conduction vias and the paste for electric circuits which were produced in Example 52.

As for the used paste for conduction vias and paste for electric circuits, it is what contains an aluminum nitride 5 weight %.

Processing was performed so that the size of the substrate for light emitting device mounting which has cavity space might become 10 mm×10 mm×thickness of 2 mm after firing.

The substrate thickness of the portion in which the light emitting device in cavity space is mounted was processed so that it might be set to 0.5 mm after firing.

Therefore, the depth of cavity space is processed so that it may be set to 1.5 mm after firing.

The substrate thickness of a cavity space side wall part is processed so that it may be set to 1.5 mm after firing.

After drying the green sheet processing objects which were acquired like this, they were co-fired at 1820 degrees C. for 2 hours in the pure N₂ atmosphere of normal pressure after degreasing suitably in the atmosphere which comprises as the main ingredients nitrogen or nitrogen/carbon dioxide mixed gas, and the sintered compacts of having a cavity space which comprise an aluminum nitride as the main ingredients and which formed an electric circuit in the inside and on the surface and a conduction via in the inside were obtained.

As for the composition of the obtained sintered compacts which comprise an aluminum nitride as the main ingredients, each ingredient of Y₂O₃, CaO, and Er₂O₃ which existed in the large quantity at the time of a green sheet remained in a quantity almost as it is, the oxygen in raw material also remained in a quantity almost as it is.

Some things were selected from the obtained sintered compacts of each composition which comprise an aluminum nitride as the main ingredients, respectively, the side wall portion which forms cavity space is removed by grinding, they were processed with a thickness of 0.5 mm in the shape of a plate.

It prevented from shaving off the electric circuit which is being formed on the substrate surface at the time of grinding.

Thus, the optical transmissivity to the monochromatic light with a wavelength 605 nm of the sintered compact which formed the electric circuit in the inside and on the surface and were obtained was measured by using the thing of each composition.

Consequently, they are not less than 50% altogether, optical transmissivity was 65% in what has Y₂O₃ of 5 weight %, optical transmissivity was 61% in what has Y₂O₃ of 5 weight % and CaO of 0.5 weight %, optical transmissivity was 64% in what has Er₂O₃ of 9 weight %, and optical transmissivity was 62% in what has Er₂O₃ of 3 weight % and CaO of 0.5 weight %.

Next, in the remaining sintered compacts which did not carry out grinding of the side wall which forms cavity space, Ni/Au plating was given to the electric circuit of the surface of cavity space and on the electric circuit of the external surface, they were cut in 10 mm×10 mm×2 mm size by the snap break, and the same substrates for light emitting device mounting as what was illustrated in FIG. 101 were produced.

These substrates for light emitting device mounting were produced about each sintered compact which comprises an aluminum nitride as the main ingredients and has the four above-mentioned kinds of composition.

The commercial light emitting device of 1 mm square which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on each produced substrate by adhering as shown in FIG. 101 by using the low melting point braze material which comprises In as the main ingredients and by carrying out reversal mounting, and it was sealed by silicone resin using the lid made from metal aluminum.

After that, 3.5 V×350 mA electric power is impressed to a light emitting device, and is made to emit light, then the penetration state from the substrate of this luminescence was confirmed with the naked eye.

Consequently, although a strong bright light which penetrated the substrate in all the produced substrates for light emitting device mounting was observed, the penetration light was gentle.

Moreover, in this penetration light, reduction of the brightness by the electric circuit which was formed by the co-firing in the inside and surface of the substrate which used the sintered compact which comprises an aluminum nitride as the main ingredients was hardly observed also in which substrate.

### EXAMPLE 54

It laminates three sheets at a time, respectively, by using the green sheets which have four kinds of different composition produced in Example 52, what was cut into the square of 35 mm square×thickness of 0.9 mm was prepared.

After drying each green sheet, and after degreasing in nitrogen atmosphere, they were fired on the two firing conditions, that is, 1) normal pressure sintering is carried out at 1800 degrees C. for 2 hours in pure N₂ atmosphere, 2) normal pressure sintering is carried out at 2200 degrees C. for 4 hours in the nitrogen atmosphere containing carbon monoxide 200 ppm, the sintered compacts which comprises an aluminum nitride as the main ingredients were obtained.

As for the composition of the sintered compact which comprises an aluminum nitride as the main ingredients and which was fired at 1800 degrees C. and obtained, each ingredient of Y₂O₃, CaO, and Er₂O₃ which existed in the large quantity at the time of a green sheet remained in a quantity almost as it is, the oxygen in raw material also remained in a quantity almost as it is.

On the other hand, as for the sintered compact which comprises an aluminum nitride as the main ingredients and which was fired at 2200 degrees C. and obtained, most of each ingredient of Y₂O₃, CaO, and Er₂O₃ which existed in the large quantity at the time of a green sheet was vaporized, the content of Y₂O₃, CaO, and Er2O₃ was not more than 100 ppm by element conversion of Y, Ca, and Er in the sintered compact obtained from the green sheet of all four kinds of composition.

Moreover, the content of oxygen contained in raw material also decreased and it was not more than 300 ppm altogether.

The aluminum nitride particle was also growing up into 30 μm-45 μm.

Both sides of each sintered compact obtained were ground to the round shape of a size with a diameter of 25.4 mm×thickness of 0.5 mm, specular surface polish processing of the surface was carried out for one side after that into 24 nm of average surface roughness.

Thus, all the optical transmissivity to monochromatic light with a wavelength 605 nm of the obtained sintered compact was not less than 50%.

Among those, all the optical transmissivity of what was fired at 2200 degrees C. for 4 hours was not less than 80%.

The various coats which consist of the metal oxide, silicon carbide, silicon nitride, and silicon which were shown in Table 63 were formed by sputter, or vapor deposition, or CVD, or the printing method of firing after being immersed to sol-gel liquid to the specular surface polish surface of these sintered compacts which comprise an aluminum nitride as the main ingredients.

In addition, among coats, the composition of what was described as PZT is 50 mol % PbTiO₃+50 mol % PbTiO₃, and the composition of what was described as PLZT is 50 mol % (90 mol % Pb+10 mol % La) ZrO₃]+50 mol % [(90 mol % Pb+10 mol % La) TiO₃].

After that, the reflectance to monochromatic light with a wavelength 605 nm of the sintered compact which comprises an aluminum nitride as the main ingredients and in which the various coats obtained were formed was measured.

In addition, the thickness of the formed various coats is 2.0 μm.

Moreover, the various above-mentioned coats are independently formed on fusion silica glass with a thickness of 1 mm in the thickness of 2.0 μm, the refractive index of the reflective material itself was measured by monochromatic light with a wavelength 605 nm.

All of the refractive index of the produced various coats were not less than 2.1 (however, except silicon), moreover, the optical transmissivity of the various coats themselves was also measured then, the optical transmissivity of all coats was not less than 80% except that the optical transmissivity of silicon was zero, and it was confirmed that the transparency is high.

These measurement results were shown in Table 63.

Although it was 10%-14% as the reflectance to monochromatic light with a wavelength 605 nm in the sintered compact which comprises an aluminum nitride as the main ingredients in which the coat is not formed (what was fired in 1800 degrees C×2 hours: reflectance of what has Y₂O₃ of 5 weight % is 14%, reflectance of what has Y₂O₃ of 5 weight % and CaO of 0.5 weight % is 12%, reflectance of what has Er₂O₃ of 9 weight % is 13%, reflectance of what has Er₂O₃ of 3 weight % and CaO of 0.5 weight % is 11%, what was fired in 2200 degrees C×4 hours: reflectance of what has Y₂O₃ of 5 weight % is 12%, reflectance of what has Y₂O₃ of 5 weight % and CaO of 0.5 weight % is 11%, reflectance of what has Er₂O₃ of 9 weight % is 12%, reflectance of what has Er₂O₃ of 3 weight % and CaO of 0.5 weight % is 10%), in the case of the sintered compact which comprises an aluminum nitride as the main ingredients in which the various above-mentioned coats were formed, in that in which the coat whose refractive index is not less than 2.1 was formed, reflectance improved to at least not less than 30%.

The reflectance of the sintered compact which comprises an aluminum nitride as the main ingredients and in which the coat whose refractive index is not less than 2.3 was formed improved to not less than 50%.

Furthermore, the reflectance of the sintered compact which comprises an aluminum nitride as the main ingredients and in which the coat whose refractive index is not less than 2.4 was formed improved to not less than 70%.

Thus, the reflectance of the sintered compact which comprises an aluminum nitride as the main ingredients and which formed various coats tends to increase according to the improvement of the refractive index of the formed coat.

Although silicon was not able to measure a refractive index, reflectance was not less than 50%. In these coats, the reflectance of the sintered compact which comprises an aluminum nitride as the main ingredients and in which TiO₂, SrTiO₃, PbTiO₃, Bi12Geo₂₀, Bi₁₂TiO₂₀, and Bi₂WO₆ were formed is not less than 90%, and it excels.

Since the refractive index of each above-mentioned coat is high, and optical transmissivity is also high in addition, this is considered to be because the light which was made total reflection in the interface between the sintered compact which comprises an aluminum nitride as the main ingredients and each above-mentioned coat which was formed is hardly absorbed.

In these six kinds of coats, that whose reflectance of the sintered compact which comprises an aluminum nitride as the main ingredients and in which TiO₂ was formed has 95% is obtained, and especially it excels.

Next, a 10 mm×10 mm×0.5 mm size was cut down by using the sintered compacts of the shape of a board which comprise an aluminum nitride as the main ingredients and which have formed the various above-mentioned coats and were produced in this Example, the electric circuit with a width of 50 μm for a light emitting device drive was formed on one side by the Ti/Pt/Au thin film, and the board-like substrates for light emitting device mounting were produced.

First, the commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the substrate which was produced by using the sintered compact which comprises an aluminum nitride as the main ingredients and in which TiO2 coat produced in experiment No. 198, 207, 210, 213, 216, and 219 were formed among them, 3.5 V×350 mA electric power is impressed to a light emitting device, and is made to emit light, then the state emitted from the substrate of this luminescence was observed with the naked eye.

Consequently, the light which penetrated the substrate which comprises an aluminum nitride as the main ingredients in all the produced substrates for light emitting device mounting is weak and is hardly observed.

Luminescence from a light emitting device turned into a strong sharp direct light, and was emitted to the substrate exterior from the substrate surface side in which this light emitting device is mounted.

In addition for reference, in the substrate for light emitting device mounting which was produced by only the sintered compact which comprises an aluminum nitride as the main ingredients and which does not form TiO₂ coat, a bright and gentle light from the light emitting device which penetrated the substrate is observed.

Thus, although the TiO₂ coat and the sintered compact which comprises an aluminum nitride as the main ingredients has optical high transmissivity, respectively, in the substrate for light emitting device mounting which was produced by using the sintered compact which comprises an aluminum nitride as the main ingredients and in which TiO₂ coat was formed, it is observed that the intensity of the light from the light emitting device which penetrates a substrate decreases dramatically.

As for the reducing of the light which penetrates such a substrate which comprises an aluminum nitride as the main ingredients, or the phenomenon in which the light which penetrates a substrate is not observed substantially, it was observed in all the substrates for light emitting device mounting which formed the coats other than TiO₂ and were produced in this Example.

Next, by using the green sheets of the four kinds of composition produced in Example 52, the sintered compacts which comprise an aluminum nitride as the main ingredients and have cavity space were produced by the two conditions of what performed the firing at 1800 degrees C. for 2 hours and what performed the firing at 2200 degrees C. for 4 hours.

The size of these sintered compacts is 10 mm×10 mm×2 mm, and the substrate thickness of a light emitting device mounting portion is 0.5 mm.

Therefore, the depth of cavity space is 1.5 mm.

Moreover, the thickness of a side wall is 0.5 mm.

After that, the electric circuit with a width of 50 μm for a light emitting device drive was formed on the light emitting device mounting portion in cavity space by the Ti/Pt/Au thin film, and the substrates for light emitting device mounting were produced.

Moreover, the board-like substrate which consists of a sintered compact of 10 mm×10 mm×0.5 mm which comprises an aluminum nitride as the main ingredients and which is used as a lid was prepared independently.

Next, TiO₂ coat was formed in the thickness of 2.0 μm to the cavity space inner side wall of the substrates for light emitting device mounting in which thin film metallizing was formed, and one side of the board-like substrate used as the above-mentioned lid.

TiO₂ coat is not formed on the surface in cavity space in which the light emitting device is mounted.

This substrate for light emitting device mounting was produced about each sintered compact which comprises an aluminum nitride as the main ingredients and which has the above-mentioned four kinds of composition.

The commercial light emitting device of 1 mm square which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on each produced substrate by adhering as shown in FIG. 92 by using the low melting point braze material which comprises In as the main ingredients and by carrying out reversal mounting, the board-like substrate which consists of a sintered compact which comprises an aluminum nitride as the main ingredients and which formed TiO₂ coat on one side and was produced beforehand was used as a lid, and it sealed with solder.

After that, 3.5 V×350 mA electric power is impressed to a light emitting device, and is made to emit light, then the penetration state from the substrate of this luminescence was confirmed with the naked eye.

Consequently, intensity of the penetration light from a lid and a substrate side wall in all the produced substrates for light emitting device mounting was weak and was hardly observed.

On the other hand, although a strong bright light which penetrated the substrate was observed from the portion in which the light emitting device was mounted, the penetration light was gentle.

As for the intensity of the light which penetrated this substrate, it was observed larger from what was fired and produced at 2200 degrees C. than from what was fired and produced at 1800 degrees C. in all the substrates produced from the green sheet which has four kinds of composition.

### EXAMPLE 55

The sintered compact which comprises an aluminum nitride as the main ingredients and which formed the vapor deposition coat of magnesium, zinc, nickel, tungsten, and molybdenum which has a thickness of 0.4 μm in all one surface was produced, in addition to the sintered compact which comprises an aluminum nitride as the main ingredients and which formed the vapor deposition coat of aluminum, gold, silver, copper, palladium, and platinum in all one surface and was produced in Example 50.

The reflectance to monochromatic light with a wavelength 605 nm of the sintered compact which comprises an aluminum nitride as the main ingredients and in which these coats were formed was measured.

The result was shown in Table 64.

As shown in Table 64, each reflectance of the sintered compact which comprises an aluminum nitride as the main ingredients and in which vapor deposition coats of magnesium and zinc were formed was as high as not less than 70%.

Especially, in the sintered compacts which comprise an aluminum nitride as the main ingredients and which carried out specular surface polish, it was not less than 80% altogether.

Moreover, each reflectance of the sintered compact which comprises an aluminum nitride as the main ingredients and in which vapor deposition coats of nickel, tungsten, and molybdenum were formed was not less than 50%.

### EXAMPLE 56

High purity aluminum nitride powder (grade “H” by Tokuyama Soda Co., Ltd. (present: Tokuyama, Inc.)) was prepared as raw material powder for sintered compact production.

This raw material powder is manufactured by method of oxide reduction.

This raw material powder contains oxygen 0.8 weight % as impurities.

Sintering aids, and a black-ized agent, etc. are added suitably to this raw powder, and they were mixed with ethanol by a ball mill for 24 hours, then dried and ethanol was vaporized, and the powder for moulding was produced by adding a paraffine wax of 5 weight % to a mixture powder, the powder for molding was produced, and the powder compact of round shape with a diameter of 36 mm×thickness of 2.0 mm was acquired by uniaxial press molding.

Paraffine wax is degreased at 300 degrees C. under decompression after that, normal pressure sintering is carried out in pure nitrogen atmosphere by using the setter and saggar which was made from an aluminum nitride, BN, tungsten, or carbon with a coating of the powder on the surface, and the sintered compact of various compositions which comprises an aluminum nitride as the main ingredients were obtained.

As for the firing, the powder compact which added a rare earth element compound and an alkaline-earth-metals compound as sintering aids was performed in 1800 degrees C×2 hours.

Moreover, the powder compact which does not add a rare earth element compound and an alkaline-earth-metals compound was fired in 1950 degrees C×2 hours.

All the obtained sintered compacts are made dense to not less than 95% of relative density. Next, the obtained sintered compacts were ground to a size with a diameter of 25.4 mm×thickness of 0.5 mm, and specular surface polish processing of the surface was carried out, as for the various sintered compacts which comprise an aluminum nitride as the main ingredients, the total amount of oxygen, the amount of ALON(s), and optical transmissivity which used 605 nm monochromatic light were measured.

Measurement of thermal conductivity and electric resistivity was also performed with some samples.

This measurement result is shown in Table 65-69.

In the obtained various sintered compacts which comprise an aluminum nitride as the main ingredients, as for oxygen which exists in raw material powder as impurities and mixed from the added alumina, or added sintering aids, such as a rare earth element compound and an alkaline-earth-metals compound, or an alkali metal compound and silicon content compound which were added, or the ingredient which promotes coloring of the added molybdenum, tungsten, niobium, titanium, carbon, etc., or added ingredients, such as iron and nickel, the same amount as the inside of a powder compact exists without the vaporizing and removing of the additive added to raw material powder.

That is, the composition of the obtained sintered compact which comprises an aluminum nitride as the main ingredients is same as the composition of a powder compact.

Therefore, as the composition of the obtained sintered compact which comprises an aluminum nitride as the main ingredients, it is not indicated in each Table especially except the total amount of oxygen.

The amount of alumina which was added when producing the above-mentioned sintered compact which comprises an aluminum nitride as the main ingredients is what was calculated by oxide conversion, the amount of oxygen in the sintered compact which comprises an aluminum nitride as the main ingredients is what was measured by element conversion.

The example which used Al₂O₃ as an additive is shown in Table 65.

The example which used a rare earth element compound and an alkaline-earth-metals compound as an additive is shown in Table 66.

In the example of an experiment of Table 66, the measurement result of the thermal conductivity in room temperature is also shown.

The example which used a silicon content compound and an alkali metal compound as an additive is shown in Table 67.

The example which used Mo, W, V, Nb, Ta, Ti, and carbon as an additive is shown in Table 68.

The example which used iron, nickel, chromium, manganese, zirconium, hafnium, cobalt, copper, and zinc as an additive is shown in Table 69.

In the example of an experiment shown in Table 68 and Table 69, the measurement result of the electric resistivity in room temperature is also shown.

In addition, the surface smooth nature of the sintered compact which comprises an aluminum nitride as the main ingredients after specular surface polish was in the range of average surface roughness (Ra)=21 nm-36 nm.

The sintered compact of optical transmissivity not more than 50% which comprises an aluminum nitride as the main ingredients was obtained in this Example as shown in Table 65-Table 69.

As for what contains comparatively a lot of oxygen (it used as an Al₂O₃), or a rare earth element compound and an alkaline-earth-metals compound, or a silicon content compound and an alkali metal compound, or Mo, W, V, Nb, Ta, Ti, carbon, or iron, nickel, chromium, manganese, zirconium, hafnium, cobalt, copper, zinc, the optical transmissivity tends to lower to not more than 10%, the thing whose optical transmissivity is 0% was also obtained easily.

As for the sintered compact which comprises an aluminum nitride as the main ingredients and was produced in the example of an experiment shown in Table 66, since the content of an aluminum nitride was not less than 50 volume %, all the thermal conductivity was not less than 50 W/mK in room temperature, and was a maximum of 172 W/mK.

Moreover, as for the sintered compact which comprises an aluminum nitride as the main ingredients and was produced in the example of an experiment shown in Table 68 and 69, since the content of an aluminum nitride was not less than 50 volume %, all the electric resistivity in room temperature is not less than 1×10⁸ Ω·cm, and had electric insulation.

After that, what is the 10 mm×10 mm size was cut down from the sintered compact which comprises an aluminum nitride as the main ingredients and was produced in this Example and which carried out specular surface polish processing and has the various compositions and the diameter of 25.4 mm×thickness of 0.5 mm, the electric circuit with a width of 50 μm for a light emitting device drive was formed on one side by the Ti/Pt/Au thin film, and the substrates for light emitting device mounting were produced.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

In addition, the center luminescence wavelength of the above-mentioned light emitting device is 460 nm.

Consequently, when the sintered compact which comprises an aluminum nitride as the main ingredients and whose optical transmissivity is in the range of 30%-50% was used, a strong light directly emitted from this light emitting device is emitted from the substrate surface side on which the light emitting device was mounted, with the naked eye, it was observed that the gentle scattered light weaker than it was emitted from the surface opposite to the substrate surface on which the light emitting device was mounted.

Moreover, in the range whose optical transmissivity of the sintered compact which comprises an aluminum nitride as the main ingredients and which is used as a substrate for light emitting device mounting is 10%-30%, according as optical transmissivity lowers to 10% from 30%, situation whose above-mentioned gentle scattered light which was emitted from the surface opposite to the substrate surface on which the light emitting device was mounted became weaker gradually was observed.

At this time, from the substrate surface side on which the light emitting device was mounted, it was observed so that a light stronger than the case where the sintered compact which comprises an aluminum nitride as the main ingredients and whose optical transmissivity is in the range of 30%-50% was used might be emitted from a light emitting device.

Moreover, in the range whose optical transmissivity of the sintered compact which comprises an aluminum nitride as the main ingredients and which uses as a substrate for light emitting device mounting is 1%-10%, situation whose above-mentioned gentle scattered light emitted from the surface opposite to the substrate surface on which the light emitting device was mounted became weaker further was observed.

Moreover, in this range, when the sintered compact which comprises an aluminum nitride as the main ingredients and whose optical transmissivity is not more than 5% was used as a substrate for light emitting device mounting, situation whose gentle scattered light emitted from the surface opposite to the substrate surface on which the light emitting device was mounted became weaker furthermore was observed.

At this time, from the substrate surface side on which the light emitting device was mounted, it was observed so that a light still stronger than the case where the sintered compact which comprises an aluminum nitride as the main ingredients and whose optical transmissivity is in the range of 10%-30% might be emitted from a light emitting device.

If the optical transmissivity of the sintered compact which comprises an aluminum nitride as the main ingredients becomes smaller than 1%, the above-mentioned gentle scattered light from the surface opposite to the substrate surface on which the light emitting device was mounted will become what is almost hard to be observed with the naked eye, from the substrate surface side on which the light emitting device was mounted, it was observed so that a light stronger than the case where the sintered compact which comprises an aluminum nitride as the main ingredients and whose optical transmissivity is in the range of 1%-10% was used might be emitted from a light emitting device at this time.

In the sintered compact which comprises an aluminum nitride as the main ingredients and whose optical transmissivity is 0%, the above-mentioned gentle scattered light from the surface opposite to the substrate surface on which the light emitting device was mounted is no longer observed with the naked eye, from the substrate surface side on which the light emitting device was mounted, it was observed as the almost same strong light as the case where the sintered compact which comprises an aluminum nitride as the main ingredients and whose optical transmissivity is smaller than 1% was used was emitted from the light emitting device at this time.

In addition, although it observed with the naked eye by mounting the light emitting device also on what uses each thin film which consists of a material constitution of Ti/W/Au, Ti/Ni/Au, Cr/Cu, and Al instead of the above-mentioned Ti/Pt/Au thin film as an electric circuit for driving a light emitting device, the situation of the light emitted from a light emitting device was the same as that of what used the Ti/Pt/Au thin film.

### EXAMPLE 57

In this Example, it investigated about the effect in case the sintered compact which comprises an aluminum nitride as the main ingredients contains oxygen (Al₂O₃), or a silicon content compound and an alkali metal compound, or Mo, W, V, and carbon, or iron simultaneously with a rare earth element compound and an alkaline-earth-metals compound which are sintering aids.

High purity aluminum nitride powder (grade “H” by Tokuyama Soda Co., Ltd. (present: Tokuyama, Inc.)) was prepared as raw material powder for sintered compact production like Example 56.

Sintering aids and various ingredients are suitably added to this raw material powder, and they were mixed with ethanol by a ball mill for 24 hours, then dried and ethanol was vaporized, and the powder for moulding was produced by adding a paraffine wax of 5 weight % to a mixture powder, the powder for molding was produced, and the powder compact of round shape with a diameter of 36 mm×thickness of 2.0 mm was acquired by uniaxial press molding.

Paraffine wax is degreased at 300 degrees C. under decompression after that, normal pressure sintering is carried out in 1800 degrees C.×2 hours in pure nitrogen atmosphere by using the setter and saggar which was made from an aluminum nitride, BN, tungsten, or carbon with a coating of the powder on the surface, and the sintered compact of various compositions which comprises an aluminum nitride as the main ingredients was obtained.

Next, the obtained sintered compacts were ground to a size with a diameter of 25.4 mm×thickness of 0.5 mm, and specular surface polish processing of the surface was carried out, as for the various sintered compacts which comprise an aluminum nitride as the main ingredients, the total amount of oxygen, the amount of ALON(s), and optical transmissivity which uses 605 nm monochromatic light were measured.

Measurement of electric resistivity was also performed with some samples.

This measurement result is shown in Table 70.

In the obtained various sintered compacts which comprise an aluminum nitride as the main ingredients, as for oxygen which exists in raw material powder as impurities and mixed from the added alumina, or added sintering aids, such as a rare earth element compound and an alkaline-earth-metals compound, or an alkali metal compound and a silicon content compound which were added, or the ingredient which promotes coloring of the added molybdenum, tungsten, niobium, titanium, carbon, etc., or added ingredients, such as iron and nickel, the same amount as the inside of a powder compact exists without the vaporizing and removing of the additive added to raw material powder.

That is, the composition of the obtained sintered compact which comprises an aluminum nitride as the main ingredients is same as the composition of a powder compact.

Therefore, as the composition of the obtained sintered compact which comprises an aluminum nitride as the main ingredients, it is not indicated in each Table especially except the total amount of oxygen.

The amount of addition of the compound which contains each ingredient of molybdenum, tungsten, vanadium, carbon, and iron among the above-mentioned additives mixed in the powder compact shown in Table 70 is based on element conversion.

The amount of alumina, yttrium oxide, erbium oxide, calcium carbonate, lithium carbonate, and silicon other than this is based on oxide conversion.

Moreover, these all amounts of addition are volume percent (volume %) except that iron is weight percentage (weight %) among each above-mentioned additive.

In addition, the surface smooth nature of the sintered compact which comprises an aluminum nitride as the main ingredients after specular surface polish was in the range of average surface roughness (Ra)=24 nm-35 nm.

Consequently, as for the sintered compact obtained by using sintering aids, although firing temperature is 1800 degrees C., all are made dense to not less than 95% of relative density.

Optical transmissivity has the tendency which is easy to improve compared with the sintered compact which comprises an aluminum nitride as the main ingredients and which was produced in Example 56 and was obtained by firing in the state where only oxygen (it used as an Al₂O₃), or a silicon content compound and alkali metal compound, or Mo, W, V, and carbon, or iron is included excluding the sintering aids.

However, also in this Example, the sintered compact which comprises an aluminum nitride as the main ingredients and whose optical transmissivity is not more than 50% was obtained.

As for what contains comparatively a lot of oxygen (it used as an Al₂O₃), or silicon content compounds and an alkali metal compound, or Mo, W, V, and carbon, or iron, optical transmissivity tends to lower to not more than 10%, and that whose optical transmissivity is 0% is obtained easily.

Moreover, the electric resistivity in room temperature has the tendency which becomes about 1 digit higher compared with the sintered compact which comprises an aluminum nitride as the main ingredients and which was produced in Example 56 and was obtained by firing in the state where only oxygen (it used as an Al₂O₃), or a silicon content compound and alkali metal compound, or Mo, W, V, and carbon, or iron is included excluding sintering aids, and the electric insulation tends to improve.

As for the sintered compact which comprises an aluminum nitride as the main ingredients and was produced in this Example, since the content of an aluminum nitride was not less than 50 volume %, all the electric resistivity in room temperature is not less than 1×10⁸ Ω·cm, and it had electric insulation.

Next, like Example 56, what is the 10 mm×10 mm size was cut down from the sintered compact which comprises an aluminum nitride as the main ingredients and was produced in this Example and which carried out specular surface polish processing and has the various compositions and the diameter of 25.4 mm×thickness of 0.5 mm, the electric circuit with a width of 50 μm for a light emitting device drive was formed on one side by the Ti/Pt/Au thin film, and the substrates for light emitting device mounting were produced.

The commercial light emitting device which laminated the epitaxial film which comprises as the main ingredients at least one or more materials selected from a gallium nitride, an indium nitride, and an aluminum nitride, and was produced by using a mixed crystal thin film of InN and GaN as a luminescence layer was mounted on the produced substrate, 3.5 V×350 mA electric power is impressed, and is made to emit light, then the penetration state from the substrate of this luminescence was confirmed with the naked eye.

In addition, the center luminescence wavelength of the above-mentioned light emitting device is 460 nm.

Consequently, when the sintered compact which comprises an aluminum nitride as the main ingredients and whose optical transmissivity is in the range of 10%-20% was used, it was observed with the naked eye so that a strong light which was directly emitted from this light emitting device is emitted from the substrate surface side on which the light emitting device was mounted, and a gentle scattered light is being emitted quite more weakly than it from the surface opposite to the substrate surface on which the light emitting device was mounted.

Moreover, in the range whose optical transmissivity of the sintered compact which comprises an aluminum nitride as the main ingredients and is used as a substrate for light emitting device mounting is 1%-10%, according as optical transmissivity lowers to 1% from 10%, situation whose above-mentioned gentle scattered light which was emitted from the surface opposite to the substrate surface on which the light emitting device was mounted became weaker gradually was observed.

At this time, from the substrate surface side on which the light emitting device was mounted, it was observed so that a light stronger than the case where the sintered compact which comprises an aluminum nitride as the main ingredients and whose optical transmissivity is in the range of 10%-20% was used might be emitted from a light emitting device.

Moreover, in this range, when the sintered compact which comprises an aluminum nitride as the main ingredients and whose optical transmissivity is not more than 5% was used as a substrate for light emitting device mounting, situation whose gentle scattered light emitted from the surface opposite to the substrate surface on which the light emitting device was mounted became weaker furthermore was observed.

At this time, from the substrate surface side on which the light emitting device was mounted, it was observed so that a light still stronger than the case where the sintered compact which comprises an aluminum nitride as the main ingredients and whose optical transmissivity is in the range of 5%-10% might be emitted from a light emitting device. If the optical transmissivity of the sintered compact which comprises an aluminum nitride as the main ingredients becomes smaller than 1%, the above-mentioned gentle scattered light from the surface opposite to the substrate surface on which the light emitting device was mounted will become what is almost hard to be observed with the naked eye, at this time, from the substrate surface side on which the light emitting device was mounted, it was observed so that a light stronger than the case where the sintered compact which comprises an aluminum nitride as the main ingredients and whose optical transmissivity is in the range of 1%-5% was used might be emitted from a light emitting device at this time.

In the sintered compact which comprises an aluminum nitride as the main ingredients and whose optical transmissivity is 0%, the above-mentioned gentle scattered light from the surface opposite to the substrate surface on which the light emitting device was mounted is no longer observed with the naked eye, from the substrate surface side on which the light emitting device was mounted, it was observed as the almost same strong light as the case where the sintered compact which comprises an aluminum nitride as the main ingredients and whose optical transmissivity is smaller than 1% was used was emitted from the light emitting device at this time.

TABLE 52

| | Additive in | | Firing | Characteristics of the sintered compact | | | | | |
|---|---|---|---|---|---|---|---|---|---|
| | the powder compact | | conditions | | | Average | | | |
| | | Amount | of the | | Average | size of | Total | Amount | |
| | | of addition | powder | Relative | size of the | the AlN | amount of | of | Optical |
| Experiment | | (volume %) | compact | density | pore | particle | oxygen | ALON | transmissivity |
| No. | Additive name | *1) | *3) | (%) | (μm) | (μm) | (weight %) | (%) | (%) |
| 1 | none | — | (2) | 99.6 | <0.5 | 16.7 | 0.7 | 1.5 | 46 |
| 2 | none | — | (3) | 99.6 | <0.5 | 4.5 | 1.0 | 2.1 | 52 |
| 3 | none | — | (4) | 99.7 | <0.5 | 8.9 | 0.9 | 1.8 | 49 |
| 4 | Al₂O₃ | 1.5 | (1) | 99.5 | 0.5 | 12.0 | 1.9 | 4.8 | 14 |
| 5 | Al₂O₃ | 16.0 | (1) | 98.9 | 0.6 | 12.1 | 9.6 | 19.7 | 3.2 |
| 6 | Al₂O₃ | 36.0 | (3) | 98.7 | 0.6 | 4.4 | 20.6 | 52 | 0.0 |
| 7 | CaCO₃ | 0.01 | (3) | 99.7 | <0.5 | 3.7 | 0.9 | 0.0 | 65 |
| 8 | Y₂O₃ | 0.01 | (3) | 99.8 | <0.5 | 3.2 | 0.9 | 0.0 | 62 |
| 9 | Y₂O₃ | 0.1 | (3) | 99.7 | <0.5 | 2.9 | 0.7 | 0.0 | 81 |
| 10 | Y₂O₃ | 0.2 | (5) | 99.7 | <0.5 | 2.5 | 0.9 | 0.0 | 52 |
| 11 | CaCO₃ | 0.4 | (5) | 99.4 | 0.5 | 4.5 | 0.8 | 0.0 | 47 |
| 12 | CaCO₃ | 0.4 | (3) | 99.7 | <0.5 | 2.7 | 0.8 | 0.0 | 70 |
| 13 | Y₂O₃ | 0.8 | (5) | 99.6 | <0.5 | 4.5 | 1.2 | 0.0 | 64 |
| 14 | CaCO₃ | 3.0 | (5) | 99.2 | 0.6 | 5.0 | 2.4 | 0.0 | 23 |
| 15 | Y₂O₃ | 2.5 | (5) | 99.7 | <0.5 | 4.2 | 1.6 | 0.0 | 66 |
| 16 | Y₂O₃ | 6.0 | (5) | 99.6 | <0.5 | 3.7 | 2.9 | 0.0 | 61 |
| 17 | Y₂O₃ | 18.0 | (5) | 99.5 | <0.5 | 4.1 | 5.9 | 0.0 | 54 |
| 18 | Y₂O₃ | 30.0 | (5) | 99.2 | <0.5 | 4.0 | 9.6 | 0.0 | 41 |
| 19 | Gd₂O₃ | 8.0 | (5) | 99.5 | <0.5 | 4.6 | 3.5 | 0.0 | 50 |
| 20 | Dy₂O₃ | 3.0 | (5) | 99.7 | <0.5 | 4.0 | 1.8 | 0.0 | 66 |
| 21 | Ho₂O₃ | 3.0 | (5) | 99.6 | <0.5 | 3.9 | 1.9 | 0.0 | 63 |
| 22 | Er₂O₃ | 0.5 | (5) | 99.6 | <0.5 | 3.7 | 1.1 | 0.0 | 57 |
| 23 | Er₂O₃ | 4.0 | (5) | 99.5 | <0.5 | 3.9 | 2.5 | 0.0 | 64 |
| 24 | Er₂O₃ | 12.0 | (5) | 99.4 | 0.5 | 4.0 | 4.3 | 0.0 | 40 |
| 25 | Yb₂O₃ | 0.8 | (5) | 99.6 | <0.5 | 3.6 | 1.1 | 0.0 | 60 |
| 26 | Li₂CO₃ | 0.5 | (3) | 99.4 | <0.5 | 2.5 | 0.9 | 1.4 | 18 |
| 27 | Si | 0.02 | (3) | 99.5 | <0.5 | 2.7 | 0.8 | 1.7 | 26 |
| 28 | Si₃N₄ | 2.5 | (3) | 99.6 | <0.5 | 2.4 | 0.8 | 0.0 | 13 |
| 29 | MoO₃ *2) | 0.05 | (1) | 99.6 | <0.5 | 10.0 | 0.8 | 0.0 | 54 |
| 30 | WO₃ *2) | 3.5 | (1) | 99.6 | <0.5 | 10.2 | 0.8 | 0.0 | 12 |
| 31 | V₂O₅ *2) | 1.0 | (1) | 99.5 | <0.5 | 11.2 | 0.9 | 0.0 | 22 |
| 32 | TiO₂ *2) | 0.05 | (1) | 99.4 | <0.5 | 12.3 | 0.8 | 0.0 | 11 |
| 33 | Nb₂O₅ *2) | 0.08 | (1) | 99.7 | <0.5 | 12.1 | 0.8 | 0.0 | 42 |
| 34 | C *2) | 0.3 | (1) | 99.4 | <0.5 | 9.4 | 0.6 | 0.0 | 25 |
| 35 | Fe *2) | 0.5 | (1) | 99.7 | <0.5 | 12.6 | 0.8 | 0.0 | 46 |
| 36 | Ni *2) | 0.2 | (1) | 99.5 | <0.5 | 12.0 | 0.9 | 0.0 | 24 |

*1) Amount of the additive is based on oxide conversion. Amount of addition of experiment No. 35 and 36 is weight %.
*2) Amount of addition of the additive of experiment No. 29-36 is based on metal element conversion.
*3) Firing conditions:
(1) 1950° C. × 4 hours; normal pressure sintering in N₂,
(2) 1950° C. × 12 hours; gas pressure sintering in N₂ (9 Kg/cm²)
(3) 1800° C. × 2 hours; hot press in N₂ (300 Kg/cm²)
(4) 1900° C. × 3 hours; HIP sintering (2000 Kg/cm²),
(5) 1800° C. × 1 hour; normal pressure sintering in N₂

TABLE 53

| | | | | Optical | Electrical |
|---|---|---|---|---|---|
| | | | | transmissivity | resistivity of |
| | | | Size | of the sintered | the |
| Ex- | | | of the | compact | conduction via |
| peri- | | Sin- | through | which has a | (×10⁻⁶ Ω · cm) |
| ment | Conduction | tering | hole | conduction via | (in room |
| No. | via material | aids | (μm) | (%) | temperature) |
| 37 | 100% | Y₂O₃ | 25 | 64 | 7.4 |
| 38 | Tungsten | | 50 | 61 | 6.9 |
| 39 | | Er₂O₃ | 25 | 63 | 7.7 |
| 40 | | | 250 | 60 | 6.6 |
| 41 | 50 volume % | Y₂O₃ | 25 | 66 | 4.9 |
| 42 | Tungsten + | | 50 | 65 | 4.4 |
| 43 | 50 volume % | Er₂O₃ | 25 | 61 | 5.0 |
| 44 | Copper | | 50 | 63 | 4.8 |
| 45 | | CaO | 25 | 56 | 5.6 |
| 46 | 100% | Y₂O₃ | 25 | 67 | 3.4 |
| 47 | Copper | | 250 | 68 | 2.9 |
| 48 | | Er₂O₃ | 25 | 63 | 3.9 |
| 49 | | | 50 | 65 | 3.1 |
| 50 | | CaO | 25 | 52 | 2.7 |
| 51 | | | 250 | 55 | 2.0 |

TABLE 54

| | Characteristics of the sintered compact | | | | | | | | | |
|---|---|---|---|---|---|---|---|---|---|---|
| | | | | | | | | | Smoothness | |
| | Additive | | | | | Average | | | of the | |
| | | Amount of | | | Average | size of | Total | Amount | substrate | |
| | | addition | Firing | Relative | pore | the AlN | amount of | of | surface | Optical |
| Experiment | Additive | (volume %) | conditions | density | size | particle | oxygen | ALON | Ra | transmissivity |
| No. | name | *1) | *3) | (%) | (μm) | (μm) | (weight %) | (%) | (nm) | (%) |
| 52 | none | — | (2) | 99.6 | <0.5 | 3.0 | 0.8 | 1.6 | 27 | 62 |
| 53 | MgO | 0.4 | (1) | 99.6 | <0.5 | 2.4 | 0.9 | 1.5 | 29 | 33 |
| 54 | CaCO₃ | 0.4 | (2) | 99.6 | <0.5 | 2.5 | 0.9 | 0.5 | 28 | 69 |
| 55 | CaCO₃ | 0.2 | (3) | 99.4 | <0.5 | 2.4 | 0.8 | 0.4 | 27 | 54 |
| 56 | Al₂O₃ | 0.4 | (1) | 99.7 | <0.5 | 2.9 | 1.0 | 2.2 | 29 | 62 |
| 57 | Y₂O₃ | 0.2 | (2) | 99.7 | <0.5 | 1.9 | 0.8 | 0.6 | 26 | 74 |
| 58 | Y₂O₃ | 0.2 | (3) | 99.6 | <0.5 | 2.3 | 0.8 | 0.5 | 28 | 56 |
| 59 | Er₂O₃ | 3.0 | (2) | 99.8 | <0.5 | 2.0 | 1.9 | 0.0 | 26 | 67 |
| 60 | Er₂O₃ | 3.0 | (3) | 99.6 | <0.5 | 2.3 | 1.9 | 0.0 | 27 | 58 |
| 61 | MoO₃ *2) | 0.5 | (1) | 99.6 | <0.5 | 3.1 | 0.9 | 1.1 | 29 | 36 |
| 62 | Cr₂O₃ *2) | 0.1 | (1) | 99.7 | <0.5 | 2.4 | 0.8 | 1.6 | 32 | 32 |

*1) Amount of the additive is based on oxide conversion.
*2) The things marked with *2) are element conversion in Experiment No. 61-62.
*3) Firing conditions:
(1) 1820° C. × 2 hours, hot press in 1 atm N₂ (300 Kg/cm²)
(2) 1900° C. × 2 hours, hot press in 1 atm N₂ (300 Kg/cm²)
(3) 1820° C. × 2 hours, normal pressure sintering in N₂

TABLE 55

Sintered compact substrates

| | | | Ultraviolet-rays |
|---|---|---|---|
| | Used substrates | | transmissivity |
| Experiment | | Experiment | (%) |
| No. | Example | No. | [300 nm] |
| 63 | Example 1 | 1 | 24 |
| 64 | Example 1 | 2 | 41 |
| 65 | Example 1 | 3 | 37 |
| 66 | Example 1 | 9 | 72 |
| 67 | Example 1 | 12 | 63 |
| 68 | Example 1 | 15 | 57 |
| 69 | Example 1 | 19 | 43 |
| 70 | Example 1 | 20 | 60 |
| 71 | Example 1 | 21 | 55 |
| 72 | Example 1 | 23 | 58 |
| 73 | Example 1 | 25 | 54 |
| 74 | Example 1 | 26 | 6.2 |
| 75 | Example 1 | 27 | 1.5 |
| 76 | Example 1 | 29 | 48 |
| 77 | Example 1 | 35 | 41 |
| 78 | Example 4 | 52 | 49 |
| 79 | Example 4 | 53 | 29 |
| 80 | Example 4 | 54 | 62 |
| 81 | Example 4 | 55 | 46 |
| 82 | Example 4 | 56 | 49 |
| 83 | Example 4 | 57 | 67 |
| 84 | Example 4 | 58 | 50 |
| 85 | Example 4 | 59 | 54 |
| 86 | Example 4 | 60 | 47 |

TABLE 56
AlN sintered compact substrates

| | | | | | Sintered compacts obtained by prolonged heating | | | | | |
|---|---|---|---|---|---|---|---|---|---|---|
| | Powder compacts | | | | Additives and | | | Amount of | Average | |
| | Kind of | | Additive | | the content | | Oxygen | the AlN | size of | |
| | raw | | content | Firing | | Content | content | crystal | the AlN | Optical |
| Experiment | material | | (weight %) | Conditions | Additive | (ppm) | (weight | phase | particle | transmissivity |
| No. | powder | Additive | *1) | *2) | element | *3) | %) | (%) | (μm) | (%) |
| 87 | Method of | none | — | (1) | — | — | 1.2 | 96.2 | 3.6 | 56 |
| 88 | oxide | none | — | (8) | — | — | 1.3 | 97.1 | 38 | 64 |
| 89 | reduction | Al₂O₃ | 2.0 | (1) | — | — | 1.5 | 96.7 | 3.7 | 18 |
| 90 | | Al₂O₃ | 2.0 | (11) | — | — | 1.4 | 97.4 | 44 | 52 |
| 91 | | CaCO₃ | 0.5 | (3) | Ca | 800 | 0.4 | 98.5 | 7.5 | 46 |
| 92 | | CaCO₃ | 0.5 | (6) | Ca | 320 | 0.17 | 99.1 | 28 | 66 |
| 93 | | CaCO₃ | 0.5 | (7) | Ca | 75 | 0.09 | Single phase | 32 | 77 |
| 94 | | CaCO₃ | 0.5 | (10) | Ca | 45 | 0.06 | Single phase | 49 | 81 |
| 95 | | Y₂O₃ | 1.0 | (3) | Y | 1900 | 0.4 | 96.9 | 8.8 | 53 |
| 96 | | Y₂O₃ | 1.0 | (7) | Y | 20 | 0.07 | Single phase | 31 | 74 |
| 97 | | Y₂O₃ | 1.0 | (10) | Y | <0.5 | 0.03 | Single phase | 46 | 82 |
| 98 | | Y₂O₃ | 5.0 | (3) | Y | 4600 | 0.7 | 96.4 | 7.7 | 37 |
| 99 | | Y₂O₃ | 5.0 | (7) | Y | 85 | 0.04 | 99.2 | 35 | 76 |
| 100 | | Y₂O₃ | 5.0 | (10) | Y | 10 | 0.02 | Single phase | 47 | 86 |
| 101 | | Y₂O₃ | 5.0 | (2) | Y | 4200 | 0.8 | 97.2 | 6.4 | 47 |
| | | CaCO₃ | 0.5 | | Ca | 200 | | | | |
| 102 | | Y₂O₃ | 5.0 | (5) | Y | 850 | 0.09 | 98.6 | 17 | 75 |
| | | CaCO₃ | 0.5 | | Ca | 65 | | | | |
| 103 | | Y₂O₃ | 5.0 | (6) | Y | 10 | 0.04 | Single phase | 29 | 81 |
| | | CaCO₃ | 0.5 | | Ca | 6 | | | | |
| 104 | | Y₂O₃ | 5.0 | (9) | Y | <0.5 | 0.02 | Single phase | 37 | 86 |
| | | CaCO₃ | 0.5 | | Ca | <0.5 | | | | |
| 105 | | Yb₂O₃ | 5.0 | (6) | Yb | 25 | 0.03 | Single phase | 27 | 82 |
| | | CaCO₃ | 0.5 | | Ca | 5 | | | | |
| 106 | | Er₂O₃ | 10.0 | (7) | Er | 170 | 0.06 | 99.2 | 30 | 68 |
| 107 | | Si | 0.5 | (4) | Si | 1500 | 0.7 | 95.5 | 11 | 42 |
| 108 | | MoO₃ | 1.0 | (4) | Mo | 2100 | 0.8 | 95.4 | 12 | 34 |
| 109 | | Carbon | 1.0 | (4) | C | 160 | 0.07 | 98.1 | 10 | 27 |
| 110 | | Fe | 0.5 | (4) | Fe | 510 | 0.3 | 96.1 | 13 | 44 |
| 111 | | Ni | 0.5 | (4) | Ni | 740 | 0.4 | 95.9 | 9.5 | 40 |

*1) Content of the sintering aid is what carried out oxide conversion.
*2) Firing conditions:
(1) 1800° C. × 2 hours
(2) 1800° C. × 12 hours
(3) 1800° C. × 24 hours
(4) 1950° C. × 4 hours
(5) 1950° C. × 12 hours
(6) 2100° C. × 4 hours
(7) 2100° C. × 12 hours
(8) 2100° C. × 24 hours
(9) 2200° C. × 4 hours
(10) 2200° C. × 8 hours
(11) 2200° C. × 12 hours
*3) Content of the sintering aid in a sintered compact is shown with the weight rate of a part per million unit. And, the content is a value in element conversion.

TABLE 57
AlN sintered compact substrates

| | Powder compacts and the sintered compacts | | | | | | | | | |
|---|---|---|---|---|---|---|---|---|---|---|
| | before prolonged heating | | | | | | | | | |
| | Kind of | | | | Sintered compacts obtained by prolonged heating | | | | | |
| | raw | | | | | | | | Average | |
| | material | | | | Additives and | | | Amount of | size of | |
| | powder | | Additive | | the content | | Oxygen | the | the | |
| | used for | | content | Firing | | Content | content | AlN crystal | AlN | Optical |
| Experiment | a powder | | (weight %) | conditions | Additive | (ppm) | (weight | phase | particle | transmissivity |
| No. | compact | Additive | *1) | *2) | element | *3) | %) | (%) | (μm) | (%) |
| 112 | Direct | Y₂O₃ | 1.0 | (3) | Y | 1700 | 0.6 | 96.4 | 9.4 | 53 |
| 113 | nitriding | Y₂O₃ | 1.0 | (7) | Y | 10 | 0.04 | Single phase | 36 | 81 |
| 114 | method of | Y₂O₃ | 1.0 | (10) | Y | <0.5 | 0.03 | Single phase | 48 | 85 |
| 115 | metal | Y₂O₃ | 5.0 | (2) | Y | 4200 | 0.7 | 96.7 | 7.2 | 51 |
| | aluminum | CaCO₃ | 0.5 | | Ca | 500 | | | | |
| 116 | (Powder | Y₂O₃ | 5.0 | (6) | Y | 6 | 0.03 | Single phase | 28 | 83 |
| | compact) | CaCO₃ | 0.5 | | Ca | 6 | | | | |
| 117 | | Y₂O₃ | 5.0 | (9) | Y | <0.5 | 0.02 | Single phase | 40 | 87 |
| | | CaCO₃ | 0.5 | | Ca | <0.5 | | | | |
| 118 | Fired | Y₂O₃ | 1.0 | (5) | Y | 920 | 0.08 | 99.1 | 20 | 77 |
| 119 | sintered | Y₂O₃ | 1.0 | (10) | Y | <0.5 | 0.02 | Single phase | 46 | 88 |
| 120 | compact *4) | Y₂O₃ | 5.0 | (7) | Y | 24 | 0.03 | Single phase | 34 | 84 |
| 121 | | Y₂O₃ | 5.0 | (6) | Y | 3 | 0.02 | Single phase | 30 | 87 |
| | | CaCO₃ | 0.5 | | Ca | 2 | | | | |

*1) Content of the sintering aid is what carried out oxide conversion.
*2) Firing conditions:
(1) 1800° C. × 2 hours
(2) 1800° C. × 12 hours
(3) 1800° C. × 24 hours
(4) 1950° C. × 4 hours
(5) 1950° C. × 12 hours
(6) 2100° C. × 4 hours
(7) 2100° C. × 12 hours
(8) 2100° C. × 24 hours
(9) 2200° C. × 4 hours
(10) 2200° C. × 8 hours
(11) 2200° C. × 12 hours
*3) Content of the sintering aid in a sintered compact is shown with the weight rate of a part per million unit. And, the content is a value in element conversion.
*4) Composition of the fired sintered compact is a blend composition at the time of the powder compact, and amount of the additive is what carried out oxide conversion.

TABLE 58

| | | | | | Optical | |
|---|---|---|---|---|---|---|
| | AlN content | | | | transmissivity of | Electric resistivity |
| | in the | Sintering | Firing | Diameter | the AlN sintered | of the |
| | tungsten paste | aids | conditions | of the | compact in which | conduction via |
| | for a | in the | of the | through | a conduction via | (×10⁻⁶ Ω · cm) |
| Experiment | conduction via | green | green | hole | was formed | (in room |
| No. | (weight %) | sheet | sheet | (μm) | (%) | temperature) |
| 122 | 0.0 | Y₂O₃ | 1800° C. × 2 | 25 | 60 | 7.0 |
| 123 | 1.0 | 5 weight % | hours | 25 | 62 | 7.5 |
| 124 | 5.0 | | | 25 | 64 | 9.1 |
| 125 | 10.0 | | | 25 | 66 | 37 |
| 126 | 20.0 | | | 25 | 68 | 69 |
| 127 | 30.0 | | | 25 | 67 | 132 |
| 128 | 0.0 | Y₂O₃ | 2200° C. × 4 | 25 | 80 | 6.8 |
| 129 | 0.1 | 5 weight % + CaO | hours | 25 | 81 | 6.9 |
| 130 | 1.0 | 0.5 | | 25 | 84 | 7.4 |
| 131 | 5.0 | weight % | | 25 | 84 | 9.7 |
| 132 | 10.0 | | | 25 | 85 | 43 |
| 133 | 1.0 | | 1800° C. × 2 | 50 | 57 | 8.0 |
| 134 | 5.0 | | hours | 50 | 65 | 9.0 |
| 135 | 0.1 | Y₂O₃ | 2200° C. × 4 | 50 | 80 | 6.9 |
| 136 | 1.0 | 5 weight % | hours | 50 | 83 | 6.9 |
| 137 | 5.0 | | | 50 | 84 | 8.2 |
| 138 | 10.0 | | | 50 | 85 | 32 |

TABLE 59

| | | | | Optical | |
|---|---|---|---|---|---|
| | | | | transmissivity | Electric |
| | | | | of the sintered | resistivity of |
| | Electric | | | compact | the internal |
| | conduction | | | which has an | electric circuit |
| | materials | | Firing | internal | (×10⁻⁶ Ω · cm) |
| Experiment | for electric | Sintering | conditions | electric circuit | (in room |
| No. | circuit | aids | *1) | (%) | temperature) |
| 139 | 100% | Y₂O₃ | (1) | 62 | 7.4 |
| 140 | Tungsten | | (2) | 83 | 8.4 |
| 141 | | Er₂O₃ | (1) | 64 | 7.7 |
| 142 | | | (2) | 81 | 8.6 |
| 143 | 50 volume % | Y₂O₃ | (1) | 66 | 4.7 |
| 144 | Tungsten + 50 | | (2) | 82 | 4.9 |
| 145 | volume % | Er₂O₃ | (1) | 65 | 4.6 |
| 146 | Copper | | (2) | 80 | 4.9 |
| 147 | | CaO | (1) | 64 | 5.4 |
| 148 | 100% | Y₂O₃ | (1) | 66 | 2.5 |
| 149 | Copper | | (2) | 86 | 3.3 |
| 150 | | Er₂O₃ | (1) | 63 | 3.5 |
| 151 | | | (2) | 84 | 3.8 |
| 152 | | CaO | (1) | 60 | 2.2 |
| 153 | | | (2) | 86 | 3.1 |

*1) Firing conditions:
(1) 1820° C. × 2 hours, normal pressure sintering in N₂
(2) 2200° C. × 4 hours, normal pressure sintering in N₂(including CO: 200 ppm)

TABLE 60

| | | Sintered compacts | | | | Sintered compacts after reflective | | |
|---|---|---|---|---|---|---|---|---|
| | | before reflective prevention material formation | | | | prevention material formation | | |
| | | | Average | Reflectance | Optical | Optical transmissivity | | |
| | | Method of | surface | of the | transmissivity | (%) | | |
| | | the | roughness | sintered | of the sintered | Reflective prevention materials | | |
| Experiment | Sintering | surface | Ra | compact | compact | Self-oxidization | Silica | Magnesia |
| No. | aids | processing | (nm) | (%) | (%) | coat | coat | coat |
| 154 | Y₂O₃ | as-fired | 160 | 9 | 61 | 74 | 73 | 74 |
| 155 | | Specular | 28 | 13 | 64 | 73 | 71 | 76 |
| | | surface | | | | | | |
| | | polish | | | | | | |
| 156 | | Lap polish | 870 | 10 | 58 | 70 | 69 | 73 |
| 157 | Er₂O₃ | as-fired | 190 | 11 | 59 | 72 | 70 | 70 |
| 158 | | Specular | 27 | 16 | 65 | 76 | 74 | 75 |
| | | surface | | | | | | |
| | | polish | | | | | | |
| 159 | | Lap polish | 750 | 12 | 61 | 72 | 74 | 70 |
| 160 | CaO | as-fired | 320 | 12 | 57 | 70 | 68 | 71 |
| 161 | | Specular | 30 | 15 | 61 | 74 | 72 | 74 |
| | | surface | | | | | | |
| | | polish | | | | | | |
| 162 | | Lap polish | 910 | 12 | 56 | 69 | 70 | 68 |

TABLE 61

| | | Sintered compacts before | | | | | | | |
|---|---|---|---|---|---|---|---|---|---|
| | | reflective material formation | | | | | | | |
| | | Surface state of | | | | | | | |
| | | the sintered compact | | | | | | | |
| | | | Average | Sintered compacts | | | | | |
| | | Surface state | surface | after reflective material formation | | | | | |
| | | and the | roughness | Reflectance (%) | | | | | |
| Experiment | Sintering | surface processing | Ra | Reflective materials | | | | | |
| No. | aids | method | (nm) | Aluminum | Gold | Silver | Copper | Palladium | Platinum |
| 163 | Y₂O₃ | as-fired | 160 | 89 | 88 | 91 | 88 | 76 | 77 |
| 164 | | Specular | 28 | 92 | 91 | 96 | 92 | 82 | 81 |
| | | surface polish | | | | | | | |
| 165 | | Lap polish | 870 | 83 | 82 | 85 | 84 | 72 | 74 |
| 166 | Er₂O₃ | as-fired | 190 | 87 | 89 | 90 | 90 | 79 | 78 |
| 167 | | Specular | 27 | 93 | 92 | 97 | 91 | 83 | 80 |
| | | surface polish | | | | | | | |
| 168 | | Lap polish | 750 | 80 | 84 | 87 | 81 | 74 | 71 |
| 169 | CaO | as-fired | 320 | 86 | 87 | 92 | 87 | 77 | 77 |
| 170 | | Specular | 30 | 91 | 92 | 97 | 92 | 80 | 81 |
| | | surface polish | | | | | | | |
| 171 | | Lap polish | 910 | 81 | 80 | 84 | 81 | 74 | 72 |

TABLE 62

| | | | | Optical | |
|---|---|---|---|---|---|
| | AlN content | | | transmissivity of | Electric resistivity |
| | in the | | | the AlN sintered | of the internal |
| | tungsten paste | | Firing | compact in which | electric circuit |
| | for internal | Sintering aids | conditions | the internal electric | in room |
| Experiment | electric circuit | in the | of the | circuit was formed | temperature |
| No. | (weight %) | green sheet | green sheet | (%) | (×10⁻⁶ Ω · cm) |
| 172 | 0.1 | Y₂O₃ | 1800° C. × 2 | 61 | 6.8 |
| 173 | 1.0 | 5 weight % | hours | 61 | 7.1 |
| 174 | 5.0 | | | 65 | 8.9 |
| 175 | 10.0 | | | 67 | 29 |
| 176 | 20.0 | | | 68 | 54 |
| 177 | 30.0 | | | 68 | 166 |
| 178 | 0.0 | Y₂O₃ | 2200° C. × 4 | 81 | 6.5 |
| 179 | 1.0 | 5 weight % + CaO | hours | 82 | 6.9 |
| 180 | 5.0 | 0.5 weight % | | 83 | 9.4 |
| 181 | 10.0 | | | 85 | 36 |
| 182 | 20.0 | | | 86 | 80 |
| 183 | 0.1 | | 1800° C. × 2 | 60 | 6.9 |
| 184 | 5.0 | | hours | 63 | 9.1 |
| 185 | 1.0 | Y₂O₃ | 2200° C. × 4 | 81 | 7.3 |
| 186 | 5.0 | 5 weight % | hours | 84 | 8.7 |
| 187 | 10.0 | | | 85 | 39 |
| 188 | 20.0 | | | 86 | 74 |
| 189 | 0.1 | Er₂O₃ | 1800° C. × 2 | 60 | 6.6 |
| 190 | 5.0 | 9 weight % | hours | 63 | 8.2 |
| 191 | 10.0 | | | 65 | 27 |
| 192 | 20.0 | | | 65 | 59 |
| 193 | 0.1 | Er₂O₃ | 2200° C. × 4 | 80 | 7.5 |
| 194 | 5.0 | 3 weight % + CaO | hours | 83 | 9.4 |
| 195 | 10.0 | 0.5 weight % | | 85 | 40 |
| 196 | 20.0 | | | 86 | 67 |

TABLE 63

| | | Firing | Coats | | | | |
|---|---|---|---|---|---|---|---|
| | Sintering aids | conditions | | | Average | | |
| Experiment | in the | of the | | Formation | refractive | Reflectance | Transmissivity |
| No. | green sheet | green sheet | Materials | methods | index | (%) | (%) |
| 197 | Y₂O₃ | 1800° C. × 2 | TiO₂ | sputter | 2.67 | 92 | 98 |
| 198 | 5 weight % | hours | Nb₂O₅ | CVD | 2.41 | 87 | 95 |
| 199 | | | Bi₁₂GeO₂₀ | sputter | 2.64 | 93 | 97 |
| 200 | | | Bi₂WO₆ | sputter | 2.51 | 91 | 96 |
| 201 | | | SiC | sputter | 2.65 | 82 | 88 |
| 202 | | | Diamond | CVD | 2.41 | 84 | 92 |
| 203 | Y₂O₃ | 2200° C. × 4 | PbMoO₄ | sputter | 2.34 | 80 | 92 |
| 204 | 5 weight % + CaO | hours | SrTiO₃ | sputter | 2.44 | 91 | 95 |
| 205 | 0.5 | | Ta₂O₅ | sputter | 2.32 | 79 | 94 |
| 206 | weight % | 1800° C. × 2 | TiO₂ | sputter | 2.67 | 93 | 97 |
| 207 | | hours | PZT | sputter | 2.43 | 87 | 96 |
| 208 | | | Si | sputter | — | 54 | — |
| 209 | Y₂O₃ | 2200° C. × 4 | TiO₂ | sol-gel | 2.56 | 91 | 96 |
| 210 | 5 weight % | hours | PbTiO₃ | sputter | 2.69 | 90 | 97 |
| 211 | | | ZrO₂ | sputter | 2.15 | 46 | 82 |
| 212 | Er₂O₃ | 1800° C. × 2 | TiO₂ | sputter | 2.67 | 93 | 97 |
| 213 | 9 weight % | hours | BaTiO₃ | sputter | 2.36 | 76 | 90 |
| 214 | | | LiNbO₃ | sputter | 2.33 | 68 | 92 |
| 215 | | 2200° C. × 4 | TiO₂ | CVD | 2.72 | 95 | 99 |
| 216 | | hours | Bi₁₂TiO₂₀ | sputter | 2.70 | 90 | 95 |
| 217 | | | Si₃N₄ | sputter | 2.14 | 59 | 89 |
| 218 | Er₂O₃ | 1800° C. × 2 | TiO₂ | CVD | 2.72 | 94 | 99 |
| 219 | 3 weight % + CaO | hours | PLZT | sputter | 2.54 | 87 | 90 |
| 220 | 0.5 | | LiTaO₃ | sputter | 2.22 | 70 | 92 |
| 221 | weight % | 2200° C. × 4 | PLT | sputter | 2.44 | 85 | 93 |
| 222 | | hours | ZnSe | sputter | 2.60 | 81 | 86 |
| 223 | | | ZnO | sputter | 2.12 | 55 | 87 |

TABLE 64

| | | Sintered compacts | | | | | | |
|---|---|---|---|---|---|---|---|---|
| | | before reflective | | | | | | |
| | | material formation | | | | | | |
| | | Surface state of the | | | | | | |
| | | sintered compact | | | | | | |
| | | Surface state | Average | Sintered compacts | | | | |
| | | and the | surface | after reflective member formation | | | | |
| | | surface | roughness | Reflectance (%) | | | | |
| Experiment | Sintering | processing | Ra | Reflective member | | | | |
| No. | aids | method | (nm) | Magnesium | Zinc | Nickel | Tungsten | Molybdenum |
| 224 | Y₂O₃ | as-fired | 160 | 82 | 80 | 62 | 54 | 53 |
| 225 | | Specular | 28 | 90 | 88 | 67 | 59 | 57 |
| | | surface polish | | | | | | |
| 226 | | Lap polish | 870 | 81 | 79 | 60 | 52 | 51 |
| 227 | Er₂O₃ | as-fired | 190 | 83 | 80 | 63 | 53 | 54 |
| 228 | | Specular | 27 | 88 | 84 | 66 | 56 | 56 |
| | | surface polish | | | | | | |
| 229 | | Lap polish | 750 | 84 | 77 | 64 | 51 | 52 |
| 230 | CaO | as-fired | 320 | 86 | 84 | 63 | 53 | 52 |
| 231 | | Specular | 30 | 87 | 85 | 66 | 57 | 55 |
| | | surface polish | | | | | | |
| 232 | | Lap polish | 910 | 83 | 84 | 59 | 52 | 51 |

TABLE 65

| Ex- | Additives | | Total | Amount | |
|---|---|---|---|---|---|
| per- | Addi- | Amount of | amount of | of | Optical |
| iment | tive | addition | oxygen | ALON | transmissivity |
| No. | name | (volume %) *1) | (weight %) | (%) | (%) |
| 233 | none | — | 0.9 | 1.3 | 44 |
| 234 | Al₂O₃ | 0.5 | 1.0 | 2.1 | 27 |
| 235 | Al₂O₃ | 2.5 | 2.1 | 5.4 | 16 |
| 236 | Al₂O₃ | 7.0 | 4.8 | 10 | 7.4 |
| 237 | Al₂O₃ | 12.0 | 7.7 | 17 | 3.9 |
| 238 | Al₂O₃ | 18.0 | 10.9 | 25 | 0.7 |
| 239 | Al₂O₃ | 24.0 | 14.1 | 34 | 0.6 |
| 240 | Al₂O₃ | 30.0 | 17.5 | 41 | 0.0 |
| 241 | Al₂O₃ | 36.0 | 20.7 | 47 | 0.0 |

*1) Amount of the additive is based on oxide conversion.

TABLE 66

| | Additives in the | | | | | |
|---|---|---|---|---|---|---|
| | powder compact | | Characteristics of the sintered compact | | | |
| | | Amount | Total | Amount | | |
| | | of | amount of | of | Optical | Thermal |
| Experiment | Additive | addition | oxygen | ALON | transmissivity | conductivity |
| No. | name | (volume %) *1) | (weight %) | (%) | (%) | (W/mK) |
| 242 | CaCO₃ | 0.5 | 0.9 | 0.0 | 46 | 171 |
| 243 | CaCO₃ | 2.5 | 1.7 | 0.0 | 28 | 156 |
| 244 | CaCO₃ | 7.0 | 2.5 | 0.0 | 4.2 | 124 |
| 245 | CaCO₃ | 35 | 10.6 | 0.0 | 0.5 | 60 |
| 246 | CaCO₃ | 48 | 15.5 | 0.0 | 0.0 | 57 |
| 247 | SrCO₃ | 2.5 | 1.4 | 0.0 | 14 | 132 |
| 248 | BaCO₃ | 26 | 5.2 | 0.0 | 3.4 | 107 |
| 249 | BeO | 40 | 24.5 | 0.0 | 0.0 | 109 |
| 250 | MgO | 4.7 | 3.1 | 0.0 | 6.7 | 60 |
| 251 | Y₂O₃ | 0.2 | 0.9 | 0.0 | 46 | 127 |
| 252 | Y₂O₃ | 27 | 8.3 | 0.0 | 4.2 | 172 |
| 253 | Y₂O₃ | 37 | 11.1 | 0.0 | 0.8 | 154 |
| 254 | Y₂O₃ | 46 | 13.0 | 0.0 | 0.0 | 107 |
| 255 | CaCO₃ | 37 | 15.4 | 0.0 | 0.0 | 86 |
| | Y₂O₃ | 10 | | | | |
| 256 | Sm₂O₃ | 37 | 9.3 | | 0.6 | 84 |
| 257 | Gd₂O₃ | 27 | 7.5 | 0.0 | 3.5 | 93 |
| 258 | Dy₂O₃ | 37 | 9.3 | 0.0 | 0.5 | 88 |
| 259 | Ho₂O₃ | 37 | 9.0 | 0.0 | 0.3 | 101 |
| 260 | Er₂O₃ | 27 | 7.2 | 0.0 | 3.7 | 115 |
| 261 | Er₂O₃ | 37 | 8.9 | 0.0 | 0.7 | 91 |
| 262 | CaCO₃ | 46 | 15.6 | 0.0 | 0.0 | 62 |
| | Er₂O₃ | 1.0 | | | | |
| 263 | Yb₂O₃ | 37 | 8.7 | 0.0 | 0.4 | 80 |

*1) Amount of the additive is based on oxide conversion.

TABLE 67

| | Additives in the | | Characteristics of | | |
|---|---|---|---|---|---|
| | powder compact | | the sintered compact | | |
| Ex- | | Amount | Total | Amount | |
| per- | | of addition | amount of | of | Optical |
| iment | Additive | (volume %) | oxygen | ALON | transmissivity |
| No. | name | *1) | (weight %) | (%) | (%) |
| 264 | Li₂CO₃ | 2.0 | 1.6 | 0.0 | 6.1 |
| 265 | Li₂CO₃ | 15 | 6.4 | 0.0 | 0.0 |
| 266 | Na₂CO₃ | 7.0 | 2.1 | 0.0 | 0.4 |
| 267 | K₂CO₃ | 4.0 | 1.5 | 0.0 | 2.2 |
| 268 | Si | 16 | 0.9 | 0.0 | 0.0 |
| 269 | Si₃N₄ | 4.0 | 1.0 | 0.0 | 0.0 |
| 270 | SiC | 8.0 | 1.0 | 0.0 | 0.0 |
| 271 | SiO₂ | 1.2 | 1.4 | 0.0 | 8.6 |

*1) Amount of the additive is based on oxide conversion.

TABLE 68

| | Additives in the | | Characteristics of the sintered compact | | | |
|---|---|---|---|---|---|---|
| | powder compact | | | | | Electric |
| | | Amount of | Total | Amount | | resistivity |
| | | addition | amount of | of | Optical | in room |
| Experiment | Additive | (volume %) | oxygen | ALON | transmissivity | temperature |
| No. | name | *1) | (weight %) | (%) | (%) | (Ω · cm) |
| 272 | MoO₃ | 0.4 | 0.8 | 0.6 | 26 | 3.1 × 10¹³ |
| 273 | MoO₃ | 2.0 | 0.8 | 0.0 | 6.9 | 2.3 × 10¹² |
| 274 | MoO₃ | 4.0 | 0.8 | 0.0 | 3.3 | 1.1 × 10¹² |
| 275 | Mo | 8.0 | 0.8 | 0.0 | 0.7 | 2.7 × 10¹⁰ |
| 276 | Mo | 12 | 0.8 | 0.0 | 0.6 | 4.2 × 10⁹ |
| 277 | Mo | 24 | 0.9 | 0.0 | 0.0 | 7.2 × 10⁸ |
| 278 | Mo | 42 | 0.9 | 0.0 | 0.0 | 4.6 × 10⁸ |
| 279 | WO₃ | 0.2 | 0.8 | 0.7 | 24 | 1.6 × 10¹³ |
| 280 | W | 15 | 0.8 | 0.0 | 0.8 | 7.9 × 10⁹ |
| 281 | W | 30 | 0.8 | 0.0 | 0.0 | 5.0 × 10⁸ |
| 282 | V₂O₅ | 4.0 | 0.9 | 0.0 | 2.4 | 2.5 × 10¹¹ |
| 283 | V | 16 | 0.9 | 0.0 | 0.6 | 2.3 × 10⁹ |
| 284 | V | 32 | 0.8 | 0.0 | 0.0 | 3.9 × 10⁸ |
| 285 | TiO₂ | 2.0 | 0.8 | 0.0 | 7.4 | 6.8 × 10¹¹ |
| 286 | TiO₂ | 12 | 0.9 | 0.0 | 0.0 | 5.7 × 10⁹ |
| 287 | Nb₂O₅ | 7.5 | 0.8 | 0.0 | 0.8 | 3.8 × 10¹⁰ |
| 288 | Nb | 15 | 0.8 | 0.0 | 0.4 | 5.4 × 10⁹ |
| 289 | Nb | 40 | 0.8 | 0.0 | 0.0 | 3.3 × 10⁸ |
| 290 | Ta₂O₅ | 7.0 | 0.8 | 0.0 | 0.5 | 6.0 × 10¹⁰ |
| 291 | Ta | 12 | 0.8 | 0.0 | 0.0 | 6.6 × 10⁹ |
| 292 | Carbon | 1.5 | 0.3 | 0.0 | 7.7 | 3.8 × 10¹² |
| 293 | Carbon | 7.0 | 0.07 | 0.0 | 0.4 | 9.1 × 10¹⁰ |
| 294 | Carbon | 15 | 0.02 | 0.0 | 0.0 | 7.4 × 10⁹ |

*1) Amount of the additive is based on element conversion.

TABLE 69

| | Additives in the | | Characteristics of the sintered compact | | | |
|---|---|---|---|---|---|---|
| | powder compact | | | | | Electric |
| | | Amount of | Total | Amount | | resistivity |
| | | addition | amount of | of | Optical | in room |
| Experiment | Additive | (weight %) | oxygen | ALON | transmissivity | temperature |
| No. | name | *1) | (weight %) | (%) | (%) | (Ω · cm) |
| 295 | Fe | 0.8 | 0.8 | 1.0 | 3.6 | 4.7 × 10¹² |
| 296 | Fe | 8.0 | 0.8 | 0.0 | 0.7 | 5.3 × 10¹¹ |
| 297 | Fe | 16 | 0.7 | 0.0 | 0.4 | 2.6 × 10⁹ |
| 298 | Fe | 32 | 0.9 | 0.0 | 0.0 | 1.3 × 10⁹ |
| 299 | NiO | 3.5 | 0.9 | 0.0 | 0.7 | 2.7 × 10¹¹ |
| 300 | Ni | 42 | 0.8 | 0.0 | 0.0 | 3.2 × 10⁸ |
| 301 | Cr | 0.8 | 0.8 | 0.0 | 2.9 | 8.4 × 10¹¹ |
| 302 | Mn | 5.0 | 0.8 | 0.0 | 0.6 | 6.8 × 10¹⁰ |
| 303 | Zr | 15 | 0.8 | 0.0 | 0.0 | 4.5 × 10⁹ |
| 304 | Hf | 7.5 | 0.8 | 0.0 | 0.7 | 7.9 × 10¹⁰ |
| 305 | CoO | 0.8 | 0.9 | 0.0 | 4.4 | 1.2 × 10¹³ |
| 306 | CuO | 12 | 1.0 | 0.0 | 0.0 | 1.6 × 10¹⁰ |
| 307 | Zn | 3.0 | 0.8 | 0.0 | 0.4 | 2.9 × 10¹² |

*1) Amount of the additive is based on element conversion.

TABLE 70

| | Additives in the | | Characteristics of the sintered compact | | | |
|---|---|---|---|---|---|---|
| | powder compact | | Total | Amount | | Electric resistivity |
| | | Amount | amount of | of | Optical | in room |
| Experiment | Additive | of | oxygen | ALON | transmissivity | temperature |
| No. | name | addition | (weight %) | (%) | (%) | (Ω · cm) |
| 308 | Al₂O₃ | 7.0 | 5.8 | 8.5 | 18 | not measured |
| | Y₂O₃ | 3.3 | | | | |
| 309 | Al₂O₃ | 24 | 14.6 | 31 | 8.1 | not measured |
| | Er₂O₃ | 8.0 | | | | |
| 310 | MoO₃ | 2.0 | 1.9 | 0.0 | 17 | 1.2 × 10¹³ |
| | Y₂O₃ | 3.3 | | | | |
| 311 | MoO₃ | 4.0 | 2.0 | 0.0 | 11 | 2.3 × 10¹² |
| | Er₂O₃ | 3.6 | | | | |
| 312 | Mo | 8.0 | 1.2 | 0.0 | 3.0 | 1.9 × 10¹¹ |
| | CaCO₃ | 1.0 | | | | |
| 313 | Mo | 24 | 1.2 | 0.0 | 0.0 | 6.4 × 10⁹ |
| | Y₂O₃ | 3.3 | | | | |
| | CaCO₃ | 0.5 | | | | |
| 314 | Mo | 42 | 0.9 | 0.0 | 0.0 | 7.8 × 10⁸ |
| | Er₂O₃ | 3.6 | | | | |
| | CaCO₃ | 0.5 | | | | |
| 315 | WO₃ | 4.0 | 1.6 | 0.0 | 8.5 | 1.9 × 10¹¹ |
| | Y₂O₃ | 3.3 | | | | |
| 316 | W | 15 | 1.1 | 0.0 | 2.1 | 3.4 × 10¹⁰ |
| | Er₂O₃ | 3.6 | | | | |
| 317 | W | 30 | 0.7 | 0.0 | 0.0 | 6.2 × 10⁸ |
| | Y₂O₃ | 3.3 | | | | |
| | CaCO₃ | 0.5 | | | | |
| 318 | V₂O₅ | 4.0 | 2.1 | 0.0 | 12 | 2.0 × 10¹² |
| | Er₂O₃ | 3.6 | | | | |
| 319 | Fe | 8.0 | 1.7 | 0.0 | 4.4 | 1.2 × 10¹² |
| | Y₂O₃ | 3.3 | | | | |
| 320 | Fe | 16 | 1.4 | 0.0 | 1.5 | 1.9 × 10¹⁰ |
| | Er₂O₃ | 3.6 | | | | |
| 321 | Fe | 32 | 1.2 | 0.0 | 0.0 | 4.5 × 10⁹ |
| | Y₂O₃ | 3.3 | | | | |
| | CaCO₃ | 0.5 | | | | |
| 322 | Li₂CO₃ | 2.0 | 2.5 | 0.0 | 14 | not measured |
| | Y₂O₃ | 3.3 | | | | |
| 323 | Li₂CO₃ | 15 | 7.0 | 0.0 | 0.0 | not measured |
| | Er₂O₃ | 3.6 | | | | |
| 324 | Li₂CO₃ | 15 | 7.9 | 0.0 | 0.0 | not measured |
| | Er₂O₃ | 8.0 | | | | |
| | CaCO₃ | 0.5 | | | | |
| 325 | Si | 8.0 | 1.9 | 0.0 | 4.7 | not measured |
| | Y₂O₃ | 3.3 | | | | |
| 326 | Si | 16 | 1.8 | 0.0 | 0.0 | not measured |
| | Er₂O₃ | 3.6 | | | | |

(Mode of the 2nd Aspect of this Invention)

As mentioned above, the 2nd aspect of this invention is related with, 1) the substrate for light emitting device mounting using the sintered compact which comprises an aluminum nitride as the main ingredients and which has optical permeability, 2) the substrate for light emitting device mounting using the sintered compact which comprises an aluminum nitride as the main ingredients and in which the reflective prevention material was formed, 3) the substrate for light emitting device mounting using the sintered compact which comprises an aluminum nitride as the main ingredients and in which the reflective material was formed, 4) the manufacture method of the substrate for light emitting device mounting, the mode includes the following contents.

Details are explained about the mode of the 2nd aspect of this invention below.

In addition, the following “Item” which is shown about the mode of the 2nd aspect of this invention differs from the above-mentioned “Item” which was shown about the mode of the 1st aspect of this invention.

Item 1. A substrate for light emitting device mounting in which a light emitting device comprises at least one or more materials selected from a gallium nitride, an indium nitride, and an aluminum nitride as the main ingredients, and the substrate consists of a sintered compact which comprises an aluminum nitride as the main ingredients and which has optical permeability.

Item 2. The substrate for light emitting device mounting as described in Item 1, wherein the sintered compact which comprises an aluminum nitride as the main ingredients is the optical transmissivity not less than 1%.

Item 3. The substrate for light emitting device mounting as described in Item 1 or 2, wherein the sintered compact which comprises an aluminum nitride as the main ingredients is the optical transmissivity not less than 5%.

Item 4. The substrate for light emitting device mounting as described in Item 1, 2, or 3, wherein the sintered compact which comprises an aluminum nitride as the main ingredients is the optical transmissivity not less than 10%.

Item 5. The substrate for light emitting device mounting as described in Item 1, 2, 3, or 4, wherein the sintered compact which comprises an aluminum nitride as the main ingredients is the optical transmissivity not less than 20%.

Item 6. The substrate for light emitting device mounting as described in Item 1, 2, 3, 4, or 5, wherein the sintered compact which comprises an aluminum nitride as the main ingredients is the optical transmissivity not less than 30%.

Item 7. The substrate for light emitting device mounting as described in Item 1, 2, 3, 4, 5, or 6, wherein the sintered compact which comprises an aluminum nitride as the main ingredients is the optical transmissivity not less than 40%.

Item 8. The substrate for light emitting device mounting as described in Item 1, 2, 3, 4, 5, 6, or 7, wherein the sintered compact which comprises an aluminum nitride as the main ingredients is the optical transmissivity not less than 50%.

Item 9. The substrate for light emitting device mounting as described in Item 1, 2, 3, 4, 5, 6, 7, or 8, wherein the sintered compact which comprises an aluminum nitride as the main ingredients is the optical transmissivity not less than 60%.

Item 10. The substrate for light emitting device mounting as described in Item 1, 2, 3, 4, 5, 6, 7, 8, or 9, wherein the sintered compact which comprises an aluminum nitride as the main ingredients is the optical transmissivity not less than 80%.

Item 11. The substrate for light emitting device mounting as described in Item 1, 2, 3, 4, 5, 6, 7, 8, 9, or 10, wherein the sintered compact which comprises an aluminum nitride as the main ingredients is the optical transmissivity not less than 85%.

Item 12. The substrate for light emitting device mounting as described in Item 1, 2, 3, 4, 5, 6, 7, 8, 9, 10, or 11, wherein the optical permeability or optical transmissivity of the sintered compact which comprises an aluminum nitride as the main ingredients is a thing in the light of the range of 200 nm-800 nm wavelength at least.

Item 13. A substrate for light emitting device mounting in which a light emitting device comprises at least one or more materials selected from a gallium nitride, an indium nitride, and an aluminum nitride as the main ingredients, and the substrate consists of a sintered compact which comprises an aluminum nitride as the main ingredients and which formed the reflective prevention material.

Item 14. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, or 13, and the substrate consists of a sintered compact which comprises an aluminum nitride as the main ingredients and has optical permeability and which formed the reflective prevention material.

Item 15. The substrate for light emitting device mounting as described in Item 13 or 14, wherein the reflective prevention material consists of a material with reflectance not more than 15%.

Item 16. The substrate for light emitting device mounting as described in Item 13, 14, or 15, wherein the reflective prevention material consists of a material with refractive index not more than 2.3.

Item 17. The substrate for light emitting device mounting as described in Item 16, wherein the reflective prevention material consists of a material with refractive index not more than 2.1.

Item 18. The substrate for light emitting device mounting as described in Item 16 or 17, wherein the reflective prevention material consists of a material with refractive index not more than 2.0.

Item 19. The substrate for light emitting device mounting as described in Item 13, 14, 15, 16, 17, or 18, wherein the reflective prevention material consists of a material with optical transmissivity not less than 30%.

Item 20. The substrate for light emitting device mounting as described in Item 19, wherein the reflective prevention material consists of a material with optical transmissivity not less than 50%.

Item 21. The substrate for light emitting device mounting as described in Item 19 or 20, wherein the reflective prevention material consists of a material with optical transmissivity not less than 70%.

Item 22. The substrate for light emitting device mounting as described in Item 19, 20, or 21, wherein the reflective prevention material consists of a material with optical transmissivity not less than 80%.

Item 23. The substrate for light emitting device mounting as described in Item 15, 16, 17, 18, 19, 20, 21, or 22, wherein the reflectance, refractive index, and optical transmissivity of the reflective prevention material, respectively, is a thing in the light of the range of 200 nm-800 nm wavelength at least.

Item 24. The substrate for mounting a light emitting device as described in Item 15, 16, 17, 18, 19, 20, 21, 22, or 23, wherein the reflective prevention material comprises as the main ingredients at least one or more materials selected from glass, resin, metal oxide, metal nitride, and metal carbide.

Item 25. The substrate for light emitting device mounting as described in Item 24, wherein the glass used as a reflective prevention material comprises as the main ingredients at least one or more materials selected from quartz glass, high silica glass, soda lime glass, lead soda glass, potash glass, lead potash glass, aluminosilicate glass, borosilicate glass, nonalkali glass, chalcogenide glass, telluride glass, orthophosphate glass, lanthanum glass, lithium content glass, barium content glass, zinc content glass, fluoride content glass, lead content glass, nitrogen content glass, germanium content glass, crown glass, boro crown glass, dense barium crown glass, a rare earth element, or niobium, the crown glass containing tantalum, flint glass, light flint glass, dense flint glass, flint glass containing a rare earth element or niobium, tantalum, solder glass, optical glass, and various crystallized glass.

Item 26. The substrate for light emitting device mounting as described in Item 24, wherein the resin used as a reflective prevention material comprises as the main ingredients at least one or more materials selected from epoxy resin, silicone resin, polyimide resin, phenol resin, bismaleimide triazine resin (BT resin), unsaturated polyester, fluoroplastic, such as PTFE, and PFA, FEP or PVdF, acrylic resin, methacrylic resin, poly methyl methacrylate resin (PMMA), styrene acrylonitrile copolymerization resin (SAN), allyl diglycolic carbonate resin (ADC), polyurethane resin, thiourethane resin, diallylphthalate resin (DAP), polystyrene, polyether ether ketone (PEEK), polyethylenenaphthalate (PEN), thermoplastic polyimide resin, polyamide imide (PAI), saturation polyester, polyethylene terephthalate (PET), a polybutylene terephthalate (PBT), polycarbonate (PC), polyamide, polyphenylene sulfide (PPS), polyphenylene ether (PPE), polyphenylene oxide (PPO), polyether imide (PEI), polyether sulfone (PES), polymethyl pentene (PMP), polyethylene (PE), polypropylene (PP), ethylene vinyl alcohol copolymer, polysulfone, polyalylate, diallyl phthalate, polyacetal, etc.

Item 27. The substrate for light emitting device mounting as described in Item 24, wherein the metal oxide, metal nitride, and metal carbide which are used as a reflective prevention material comprise as the main ingredients at least one or more materials selected from beryllium (Be), magnesium (Mg), calcium (Ca), strontium (Sr), barium (Ba), scandium (Sc), yttrium (Y), lanthanum (La), cerium (Ce), praseodymium (Pr), neodymium (Nd), samarium (Sm), europium (Eu), gadolinium (Gd), dysprosium (Dy), holmium (Ho), erbium (Er), ytterbium (Yb), lutetium (Lu), zirconium (Zr), hafnium (Hf), niobium (Nb), tantalum (Ta), molybdenum (Mo), tungsten (W), zinc (Zn), boron (B), aluminum (Al), gallium (Ga), indium (In), silicon (Si), germanium (Ge), tin (Sn), and antimony (Sb).

Item 28. The substrate for light emitting device mounting as described in Item 24 or 27, wherein the reflective prevention material comprises as the main ingredients at least one or more materials selected from an aluminum oxide, a silicon oxide, and a magnesium oxide.

Item 29. The substrate for light emitting device mounting as described in Item 24, 27, or 28, wherein the reflective prevention material consists of a self-oxidization coat of the sintered compact which comprises an aluminum nitride as the main ingredients.

Item 30. A substrate for light emitting device mounting in which a light emitting device comprises at least one or more materials selected from a gallium nitride, an indium nitride, and an aluminum nitride as the main ingredients, and the substrate consists of a sintered compact which comprises an aluminum nitride as the main ingredients and which formed the reflective material.

Item 31. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30, and the substrate consists of a sintered compact which comprises an aluminum nitride as the main ingredients and has optical permeability and which formed the reflective material.

Item 32. The substrate for light emitting device mounting as described in Item 30 or 31, wherein the reflective material consists of a material with reflectance not less than 15%.

Item 33. The substrate for light emitting device mounting as described in Item 32, wherein the reflective material consists of a material with reflectance not less than 30%.

Item 34. The substrate for light emitting device mounting as described in Item 32 or 33, wherein the reflective material consists of a material with reflectance not less than 50%.

Item 35. The substrate for light emitting device mounting as described in Item 32, 33, or 34, wherein the reflective material consists of a material with reflectance not less than 70%.

Item 36. The substrate for mounting a light emitting device as described in Item 32, 33, 34, or 35, wherein the reflective material consists of a material with reflectance not less than 80%.

Item 37. The substrate for light emitting device mounting as described in Item 30, 31, 32, 33, 34, 35, or 36, wherein the reflective material consists of a material with refractive index not less than 2.1.

Item 38. The substrate for light emitting device mounting as described in Item 37, wherein the reflective material consists of a material with refractive index not less than 2.3.

Item 39. The substrate for light emitting device mounting as described in Item 37 or 38, wherein the reflective material consists of a material with refractive index not less than 2.4.

Item 40. The substrate for light emitting device mounting as described in Item 30, 31, 32, 33, 34, 35, 36, 37, 38, or 39, wherein the reflective material consists of a material with optical transmissivity not less than 30%.

Item 41. The substrate for light emitting device mounting as described in Item 40, wherein the reflective material consists of a material with optical transmissivity not less than 50%.

Item 42. The substrate for light emitting device mounting as described in Item 40 or 41, wherein the reflective material consists of a material with optical transmissivity not less than 80%.

Item 43. The substrate for light emitting device mounting as described in Item 32, 33, 34, 35, 36, 37, 38, 39, 40, 41, or 42, wherein the reflectance, refractive index, and optical transmissivity of the reflective material, respectively, is a thing in the light of the range of 200 nm-800 nm wavelength at least.

Item 44. The substrate for light emitting device mounting as described in Item 30, 31, 32, 33, 34, 35, 36, or 43, wherein the reflective material comprises as the main ingredients at least one or more materials selected from metal and alloy.

Item 45. The substrate for light emitting device mounting as described in Item 30, 31, 32, 33, 34, 35, 36, or 37, wherein the reflective material comprises as the main ingredients at least one or more elements selected from Be, Mg, Sc, Y, a rare earth metal, Ti, Zr, Hf, V, Nb, Ta, Cr, Mo, W, Mn, Re, Fe, Co, Ni, Ru, Rh, Pd, Os, Ir, Pt, Cu, Ag, Au, Zn, B, Al, Ga, In, Si, Ge, Sn, Pb, Sb, Bi.

Item 46. The substrate for light emitting device mounting as described in Item 45, wherein the reflective material comprises as the main ingredients at least one or more elements selected from Cu, Ag, Au, Al, Mg, Zn, Mo, W, Mn, Fe, Co, Ni, Rh, Pd, Os, Ir, Pt, W/Cu alloy, Mo/Cu alloy, W/Ag alloy, Mo/Ag alloy, W/Au alloy, and Mo/Au alloy.

Item 47. The substrate for light emitting device mounting as described in Item 45 or 46, wherein the reflective material comprises as the main ingredients at least one or more elements selected from Cu, Ag, Au, Al, Mg, Zn, Fe, Co, Ni, Rh, Pd, Os, Ir, Pt, W/Cu alloy, Mo/Cu alloy, W/Ag alloy, Mo/Ag alloy, W/Au alloy, and Mo/Au alloy.

Item 48. The substrate for light emitting device mounting as described in Item 45, 46, or 47, wherein the reflective material consists of a material which comprises as the main ingredients Cu, Ag, Au, and Al.

Item 49. The substrate for light emitting device mounting as described in Item 30, 31, 32, 33, 34, 35, 36, 37, 38, 39, 40, 41, 42, or 43, wherein the reflective material comprises as the main ingredients at least one or more materials selected from element simple substance, metal oxide, metal nitride, metal carbide, and metal silicide.

Item 50. The substrate for light emitting device mounting as described in Item 49, wherein the reflective material comprises as the main ingredients at least one or more materials selected from TiO₂, BaTiO₃, SrTiO₃, CaTiO₃, PbTiO₃, PZT [Pb(Zr, Ti)O₃], PLZT [(Pb, La) (Zr, Ti)O₃], PLT [(Pb, La) TiO₃], ZrO₂, ZnO, ZnSe, Nb₂O₅, Ta₂O₅, LiNbO₃, LiTaO₃, SBN [(Sr1-xBax) Nb2O₆], BNN (Ba₂NaNb₅O₁₅), Bi₁₂GeO₂₀, Bi₁₂TiO₂₀, Bi₂WO₆, PbMoO₄, PbMoO₅, TeO₂, SiC, Si₃N₄, diamond, Si, Ge, chalcogenide glass.

Item 51. The substrate for light emitting device mounting as described in Item 49 or 50, wherein the reflective material comprises as the main ingredients at least one or more materials selected from TiO₂, SrTiO₃, PbTiO₃, PZT [Pb(Zr, Ti) O3], PLZT [(Pb, La) (Zr, Ti) O3], PLT [(Pb, La) TiO₃], ZnSe, Nb2O5, Bi₁₂GeO₂₀, Bi₁₂TiO₂₀, Bi₂WO₆, TeO₂ and SiC, diamond, and chalcogenide glass.

Item 52. The substrate for light emitting device mounting as described in Item 49, 50, or 51, wherein the reflective material comprises as the main ingredients at least one or more materials selected from TiO₂, SrTiO₃, PbTiO₃, Bi12GeO₂₀, Bi₁₂TiO₂₀, Bi₂WO₆.

Item 53. The substrate for light emitting device mounting as described in Item 49, 50, 51, or 52, wherein the reflective material consists of a material which comprises TiO₂ as the main ingredients.

Item 54. The substrate for light emitting device mounting as described in Item 30, 31, 32, 33, 34, 35, 36, 37, 38, 39, 40, 41, 42, 43, 44, 45, 46, 47, 48, 49, 50, 51, 52, or 53, wherein the reflective material consists of a material in which total reflection generates by the light of the range of 200 nm-800 nm wavelength at least.

Item 55. The substrate for light emitting device mounting in which a light emitting device comprises at least one or more materials selected from a gallium nitride, an indium nitride, and an aluminum nitride as the main ingredients and was described in Item 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, or 54, and the substrate consists of a sintered compact which comprises an aluminum nitride as the main ingredients, and at least either which is selected from the reflective prevention material and the reflective material is formed in this substrate.

Item 56. The substrate for light emitting device mounting in which a light emitting device comprises at least one or more materials selected from a gallium nitride, an indium nitride, and an aluminum nitride as the main ingredients and was described in Item 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55, and the substrate consists of a sintered compact which comprises an aluminum nitride as the main ingredients, and the reflective prevention material and the reflective material are simultaneously formed in this substrate.

Item 57. The substrate for light emitting device mounting in which a light emitting device comprises at least one or more materials selected from a gallium nitride, an indium nitride, and an aluminum nitride as the main ingredients and was described in Item 55 or 56, and the substrate consists of a sintered compact comprising an aluminum nitride as the main ingredients, and at least either which is selected from the reflective prevention material and the reflective material is formed in at least either which is selected from the inside and surface of the sintered compact comprising an aluminum nitride as the main ingredients.

Item 58. The substrate for light emitting device mounting in which a light emitting device comprises at least one or more materials selected from a gallium nitride, an indium nitride, and an aluminum nitride as the main ingredients and was described in Item 55, 56, or 57, and the substrate consists of a sintered compact comprising an aluminum nitride as the main ingredients, and the reflective prevention material and the reflective material are simultaneously formed in at least either which is selected from the inside and surface of the sintered compact comprising an aluminum nitride as the main ingredients.

Item 59. The substrate for light emitting device mounting as described in Item 55, 56, 57, or 58, wherein the sintered compact which comprises an aluminum nitride as the main ingredients has optical permeability.

Item 60. A substrate for light emitting device mounting in which a light emitting device comprises at least one or more materials selected from a gallium nitride, an indium nitride, and an aluminum nitride as the main ingredients, and the substrate consists of a sintered compact which comprises an aluminum nitride as the main ingredients, luminescence from the light emitting device can be emitted into the arbitrary direction of a substrate.

Item 61. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60, and the substrate consists of a sintered compact which comprises an aluminum nitride as the main ingredients and which has optical permeability, and the luminescence from the light emitting device can be emitted into the arbitrary direction of a substrate.

Item 62. The substrate for light emitting device mounting in which a light emitting device comprises at least one or more materials selected from a gallium nitride, an indium nitride, and an aluminum nitride as the main ingredients and was described in Item 60 or 61, and the substrate consists of a sintered compact which comprises an aluminum nitride as the main ingredients, and the reflective prevention material is formed in the substrate, and the luminescence from the light emitting device can be emitted into the arbitrary direction of a substrate.

Item 63. The substrate for light emitting device mounting in which a light emitting device comprises at least one or more materials selected from a gallium nitride, an indium nitride, and an aluminum nitride as the main ingredients and was described in Item 60, 61, or 62, and the substrate consists of a sintered compact which comprises an aluminum nitride as the main ingredients, and the reflective material is formed in the substrate, and that the luminescence from the light emitting device can be emitted into the arbitrary direction of a substrate.

Item 64. The substrate for light emitting device mounting in which a light emitting device comprises at least one or more materials selected from a gallium nitride, an indium nitride, and an aluminum nitride as the main ingredients and was described in Item 60, 61, 62, or 63, and the substrate consists of a sintered compact which comprises an aluminum nitride as the main ingredients, and the reflective prevention material and the reflective material are simultaneously formed in the substrate, and the luminescence from the light emitting device can be emitted into the arbitrary direction of a substrate.

Item 65. The substrate for light emitting device mounting as described in Item 60, 61, 62, 63, or 64, wherein the luminescence from a light emitting device can be emitted into all directions of the circumference space of a substrate.

Item 66. The substrate for light emitting device mounting as described in Item 60, 61, 62, 63, 64, or 65, wherein the luminescence from a light emitting device can be emitted also in the direction of the opposite side of a substrate surface on which the light emitting device is mounted.

Item 67. The substrate for light emitting device mounting as described in Item 66, wherein the luminescence from a light emitting device is emitted also in the direction of the opposite side of a substrate surface on which the light emitting device is mounted by penetrating a substrate.

Item 68. The substrate for light emitting device mounting which has a cavity space and was described in Item 60, 61, 62, 63, 64, 65, 66, or 67, and the luminescence from a light emitting device is emitted from the side surface of a substrate.

Item 69. The substrate for light emitting device mounting which has a cavity space and was described in Item 68, and the luminescence from a light emitting device is emitted from the side surface of a substrate by penetrating the substrate side wall in the inside of a cavity space.

Item 70. The substrate for light emitting device mounting in which a light emitting device comprises at least one or more materials selected from a gallium nitride, an indium nitride, and an aluminum nitride as the main ingredients and was described in Item 60, 61, 62, 63, 64, 65, 66, or 67, and the luminescence from a light emitting device is emitted mainly to the side of a substrate surface on which a light emitting device is mounted.

Item 71. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70, and the substrate consists of a sintered compact which comprises an aluminum nitride as the main ingredients and which is the optical transmissivity not more than 50%.

Item 72. The substrate for light emitting device mounting in which a light emitting device comprises at least one or more materials selected from a gallium nitride, an indium nitride, and an aluminum nitride as the main ingredients and was described in Item 71, and the substrate consists of a sintered compact which comprises an aluminum nitride as the main ingredients and which is the optical transmissivity not more than 30%.

Item 73. The substrate for light emitting device mounting in which a light emitting device comprises at least one or more materials selected from a gallium nitride, an indium nitride, and an aluminum nitride as the main ingredients and was described in Item 71 or 72, and the substrate consists of a sintered compact which comprises an aluminum nitride as the main ingredients and which is the optical transmissivity not more than 10%.

Item 74. The substrate for light emitting device mounting in which a light emitting device comprises at least one or more materials selected from a gallium nitride, an indium nitride, and an aluminum nitride as the main ingredients and was described in Item 71, 72, or 73, and the substrate consists of a sintered compact which comprises an aluminum nitride as the main ingredients and which is the optical transmissivity not more than 5%.

Item 75. The substrate for light emitting device mounting in which a light emitting device comprises at least one or more materials selected from a gallium nitride, an indium nitride, and an aluminum nitride as the main ingredients and was described in Item 71, 72, 73, or 74, and the substrate consists of a sintered compact which comprises an aluminum nitride as the main ingredients and which is the transmissivity not more than 1%.

Item 76. The substrate for light emitting device mounting in which a light emitting device comprises at least one or more materials selected from a gallium nitride, an indium nitride, and an aluminum nitride as the main ingredients and was described in Item 71, 72, 73, 74, or 75, and the substrate consists of a sintered compact which comprises an aluminum nitride as the main ingredients and whose optical transmissivity is 0%.

Item 77. The substrate for light emitting device mounting in which a light emitting device comprises at least one or more materials selected from a gallium nitride, an indium nitride, and an aluminum nitride as the main ingredients and was described in Item 71, 72, 73, 74, 75, or 76, and the substrate consists of a sintered compact which comprises an aluminum nitride as the main ingredients and which is the optical transmissivity not more than 50%, and the luminescence from a light emitting device is emitted mainly to the side of a substrate surface on which a light emitting device is mounted.

Item 78. The substrate for light emitting device mounting in which a light emitting device comprises at least one or more materials selected from a gallium nitride, an indium nitride, and an aluminum nitride as the main ingredients and was described in Item 71, 72, 73, 74, 75, 76, or 77, and the substrate consists of a sintered compact which comprises an aluminum nitride as the main ingredients and which is the optical transmissivity not more than 50%, and at least either which is selected from the reflective prevention material and the reflective material is formed in the substrate, and the luminescence from a light emitting device is emitted mainly to the side of a substrate surface on which a light emitting device is mounted.

Item 79. The substrate for light emitting device mounting in which a light emitting device comprises at least one or more materials selected from a gallium nitride, an indium nitride, and an aluminum nitride as the main ingredients and was described in Item 78, and the substrate consists of a sintered compact which comprises an aluminum nitride as the main ingredients and which is the optical transmissivity not more than 50%, and both of the reflective prevention material and reflective material are simultaneously formed in the substrate, and the luminescence from a light emitting device is emitted mainly to the side of a substrate surface on which a light emitting device is mounted.

Item 80. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39,40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, or 79, and the substrate consists of a sintered compact which comprises an aluminum nitride as the main ingredients and which contains an aluminum nitride not more than 50 volume %.

Item 81. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80, and the substrate consists of a sintered compact which comprises an aluminum nitride as the main ingredients and which contains at least one or more materials selected from a rare earth element or an alkaline-earth metal not more than 50 volume % by oxide conversion.

Item 82. The substrate for light emitting device mounting as described in Item 81 which is characterized by consisting of a sintered compact which comprises an aluminum nitride as the main ingredients and which contains at least one or more materials selected from a rare earth element or an alkaline-earth metal not more than 40 volume % by oxide conversion.

Item 83. The substrate for light emitting device mounting as described in Item 81 or 82 which is characterized by consisting of a sintered compact which comprises an aluminum nitride as the main ingredients and which contains at least one or more materials selected from a rare earth element or an alkaline-earth metal not more than 30 volume % by oxide conversion.

Item 84. The substrate for light emitting device mounting as described in Item 81, 82, or 83 which is characterized by consisting of a sintered compact which comprises an aluminum nitride as the main ingredients and which contains at least one or more materials selected from a rare earth element or an alkaline-earth metal not more than 12 volume % by oxide conversion.

Item 85. The substrate for light emitting device mounting as described in Item 81, 82, 83, or 84 which is characterized by consisting of a sintered compact which comprises an aluminum nitride as the main ingredients and which contains at least one or more materials selected from a rare earth element or an alkaline-earth metal not more than 7 volume % by oxide conversion.

Item 86. The substrate for light emitting device mounting as described in Item 81, 82, 83, 84, or 85 which is characterized by consisting of a sintered compact which comprises an aluminum nitride as the main ingredients and which contains at least one or more materials selected from a rare earth element or an alkaline-earth metal not more than 5 volume % by oxide conversion.

Item 87. The substrate for light emitting device mounting as described in Item 81, 82, 83, 84, 85, or 86 which is characterized by consisting of a sintered compact which comprises an aluminum nitride as the main ingredients and which contains at least one or more materials selected from a rare earth element or an alkaline-earth metal not more than 3 volume % by oxide conversion.

Item 88. The substrate for light emitting device mounting as described in Item 81, 82, 83, 84, 85, 86, or 87, wherein the sintered compact which comprises an aluminum nitride as the main ingredients contains only either of a rare earth element or an alkaline-earth metal.

Item 89. The substrate for light emitting device mounting as described in Item 81, 82, 83, 84, 85, 86, 87, or 88, wherein the sintered compact which comprises an aluminum nitride as the main ingredients contains simultaneously a rare earth element and an alkaline-earth metal.

Item 90. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, or 89, and the substrate consists of a sintered compact which comprises an aluminum nitride as the main ingredients and which contains at least one or more materials selected from an alkaline metal or silicon not more than 20% by oxide conversion.

Item 91. The substrate for light emitting device mounting as described in Item 90 which is characterized by consisting of a sintered compact which comprises an aluminum nitride as the main ingredients and which contains at least one or more compounds selected from an alkaline metal or silicon not more than 10 volume % by oxide conversion.

Item 92. The substrate for light emitting device mounting as described in Item 90 or 91 which is characterized by consisting of a sintered compact which comprises an aluminum nitride as the main ingredients and which contains at least one or more materials selected from an alkaline metal or silicon not more than 5 volume % by oxide conversion.

Item 93. The substrate for light emitting device mounting as described in Item 90, 91, or 92 which is characterized by consisting of a sintered compact which comprises an aluminum nitride as the main ingredients and which contains at least one or more compounds selected from an alkaline metal or silicon not more than 3 volume % by oxide conversion.

Item 94. The substrate for light emitting device mounting as described in Item 90, 91, 92, or 93 which is characterized by consisting of a sintered compact which comprises an aluminum nitride as the main ingredients and which contains at least one or more compounds selected from an alkaline metal or silicon not more than 1 volume % by oxide conversion.

Item 95. The substrate for light emitting device mounting as described in Item 81, 82, 83, 84, 85, 86, 87, 88, 89, 90, 91, 92, 93, or 94 which is characterized by consisting of a sintered compact which comprises an aluminum nitride as the main ingredients and contains at least one or more compounds selected from an alkaline metal or silicon and which contains simultaneously at least one or more materials selected from a rare earth element or an alkaline-earth metal.

Item 96. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, or 95, and the substrate consists of a sintered compact which comprises an aluminum nitride as the main ingredients and which contains at least one or more elements selected from Mo, W, V, Nb, Ta, Ti, and carbon not more than 50 volume % by element conversion.

Item 97. The substrate for light emitting device mounting as described in Item 96 which is characterized by consisting of a sintered compact which comprises an aluminum nitride as the main ingredients and which contains at least one or more elements selected from Mo, W, V, Nb, Ta, Ti, and carbon not more than 20 volume % by element conversion.

Item 98. The substrate for light emitting device mounting as described in Item 96 or 97 which is characterized by consisting of a sintered compact which comprises an aluminum nitride as the main ingredients and which contains at least one or more elements selected from Mo, W, V, Nb, Ta, Ti, and carbon not more than 10 volume % by element conversion.

Item 99. The substrate for light emitting device mounting as described in Item 96, 97, or 98 which is characterized by consisting of a sintered compact which comprises an aluminum nitride as the main ingredients and which contains at least one or more elements selected from Mo, W, V, Nb, Ta, Ti, and carbon not more than 5 volume % by element conversion.

Item 100. The substrate for light emitting device mounting as described in Item 96, 97, 98, or 99 which is characterized by consisting of a sintered compact which comprises an aluminum nitride as the main ingredients and which contains at least one or more elements selected from Mo, W, V, Nb, Ta, Ti, and carbon not more than 3 volume % by element conversion.

Item 101. The substrate for light emitting device mounting as described in Item 96, 97, 98, 99, or 100, wherein consisting of a sintered compact which comprises an aluminum nitride as the main ingredients and which contains at least one or more elements selected from Mo, W, V, Nb, Ta, Ti, and carbon not more than 1 volume % by element conversion.

Item 102. The substrate for light emitting device mounting as described in Item 81, 82, 83, 84, 85, 86, 87, 88, 89, 90, 91, 92, 93, 94, 95, 96, 97, 98, 99, 100, or 101 which is characterized by consisting of a sintered compact which comprises an aluminum nitride as the main ingredients and contains at least one or more elements selected from Mo, W, V, Nb, Ta, Ti, and carbon and which contains simultaneously at least one or more materials selected from a rare earth element or an alkaline-earth metal.

Item 103. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, or 102, and the substrate consists of a sintered compact which comprises an aluminum nitride as the main ingredients and which contains at least one or more materials selected from unescapable impurities of a transition metal not more than 50 weight % by element conversion.

Item 104. The substrate for light emitting device mounting as described in Item 103 which is characterized by consisting of a sintered compact which comprises an aluminum nitride as the main ingredients and which contains at least one or more materials selected from unescapable impurities of a transition metal not more than 20 weight % by element conversion.

Item 105. The substrate for light emitting device mounting as described in Item 103 or 104 which is characterized by consisting of a sintered compact which comprises an aluminum nitride as the main ingredients and which contains at least one or more materials selected from unescapable impurities of a transition metal not more than 10 weight % by element conversion.

Item 106. The substrate for light emitting device mounting as described in Item 103, 104, or 105 which is characterized by consisting of a sintered compact which comprises an aluminum nitride as the main ingredients and which contains at least one or more materials selected from unescapable impurities of a transition metal not more than 1.0 weight % by element conversion.

Item 107. The substrate for light emitting device mounting as described in Item 103, 104, 105, or 106 which is characterized by consisting of a sintered compact which comprises an aluminum nitride as the main ingredients and which contains at least one or more materials selected from unescapable impurities of a transition metal not more than 0.5 weight % by element conversion.

Item 108. The substrate for light emitting device mounting as described in Item 103, 104, 105, 106, or 107 which is characterized by consisting of a sintered compact which comprises an aluminum nitride as the main ingredients and which contains at least one or more materials selected from unescapable impurities of a transition metal not more than 0.2 weight % by element conversion.

Item 109. The substrate for light emitting device mounting as described in Item 81, 82, 83, 84, 85, 86, 87, 88, 89, 103, 104, 105, 106, 107, or 108 which is characterized by consisting of a sintered compact which comprises an aluminum nitride as the main ingredients and contains at least one or more materials selected from unescapable impurities of a transition metal and which contains simultaneously at least one or more materials selected from a rare earth element or an alkaline-earth metal.

Item 110. The substrate for light emitting device mounting as described in Item 103, 104, 105, 106, 107, 108, or 109, wherein the unescapable impurities of a transition metal are iron, nickel, chromium, manganese, zirconium, hafnium, cobalt, copper, and zinc.

Item 111. The substrate for light emitting device mounting as described in Item 96, 97, 98, 99, 100, 101, 102, 103, 104, 105, 106, 107, 108, 109, or 110, wherein the electric resistivity is not less than 1×10⁸ Ω·cm in room temperature.

Item 112. The substrate for light emitting device mounting as described in Item 111, wherein the electric resistivity is not less than 1×10⁹≠·cm in room temperature.

Item 113. The substrate for light emitting device mounting as described in Item 111 or 112, wherein the electric resistivity is not less than 1×10¹⁰ Ω·cm in room temperature.

Item 114. The substrate for light emitting device mounting as described in Item 111, 112, or 113, wherein the electric resistivity is not less than 1×10¹¹ Ω·cm in room temperature.

Item 115. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, or 114, and the substrate consists of a sintered compact which comprises an aluminum nitride as the main ingredients and which contains oxygen not more than 25 weight %.

Item 116. The substrate for light emitting device mounting as described in Item 115 which is characterized by consisting of a sintered compact which comprises an aluminum nitride as the main ingredients and which contains oxygen not more than 15 weight %.

Item 117. The substrate for light emitting device mounting as described in Item 115 or 116 which is characterized by consisting of a sintered compact which comprises an aluminum nitride as the main ingredients and which contains oxygen not more than 10 weight %.

Item 118. The substrate for light emitting device mounting as described in Item 115, 116, or 117 which is characterized by consisting of a sintered compact which comprises an aluminum nitride as the main ingredients and which contains oxygen not more than 5 weight %.

Item 119. The substrate for light emitting device mounting as described in Item 115, 116, 117, or 118 which is characterized by consisting of a sintered compact which comprises an aluminum nitride as the main ingredients and which contains oxygen not more than 3 weight %.

Item 120. The substrate for light emitting device mounting as described in Item 81, 82, 83, 84, 85, 86, 87, 88, 89, 115, 116, 117, 118, or 119 which is characterized by consisting of a sintered compact which comprises an aluminum nitride as the main ingredients and contains oxygen and which contains simultaneously at least one or more materials selected from a rare earth element or an alkaline-earth metal.

Item 121. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, or 120, and the substrate consists of a sintered compact which comprises an aluminum nitride as the main ingredients and which contains ALON not more than 50%.

Item 122. The substrate for light emitting device mounting as described in Item 121 which is characterized by consisting of a sintered compact which comprises an aluminum nitride as the main ingredients and which contains ALON not more than 40%.

Item 123. The substrate for light emitting device mounting as described in Item 121 or 122 which is characterized by consisting of a sintered compact which comprises an aluminum nitride as the main ingredients and which contains ALON not more than 20%.

Item 124. The substrate for light emitting device mounting as described in Item 121, 122, or 123 which is characterized by consisting of a sintered compact which comprises an aluminum nitride as the main ingredients and which contains ALON not more than 12%.

Item 125. The substrate for light emitting device mounting as described in Item 121, 122, 123, or 124 which is characterized by consisting of a sintered compact which comprises an aluminum nitride as the main ingredients and which contains ALON not more than 7%.

Item 126. The substrate for light emitting device mounting as described in Item 81, 82, 83, 84, 85, 86, 87, 88, 89,121,122,123,124, or 125 which is characterized by consisting of a sintered compact which comprises an aluminum nitride as the main ingredients and contains ALON and which contains simultaneously at least one or more materials selected from a rare earth element or an alkaline-earth metal.

Item 127. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, or 126, and the substrate consists of a sintered compact which comprises an aluminum nitride as the main ingredients and which is thermal conductivity not less than 50 W/mK in room temperature.

Item 128. The substrate for light emitting device mounting as described in Item 127, wherein the thermal conductivity of a sintered compact which comprises an aluminum nitride as the main ingredients is not less than 100 W/mK in room temperature.

Item 129. The substrate for light emitting device mounting as described in Item 127 or 128, wherein the thermal conductivity of a sintered compact which comprises an aluminum nitride as the main ingredients is not less than 150 W/mK in room temperature.

Item 130. The substrate for light emitting device mounting as described in Item 127, 128, or 129, wherein the thermal conductivity of a sintered compact which comprises an aluminum nitride as the main ingredients is not less than 170 W/mK in room temperature.

Item 131. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, or 130, and the substrate consists of a sintered compact which comprises an aluminum nitride as the main ingredients and which contains an aluminum nitride not less than 95 volume %.

Item 132. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, or 131, and the substrate consists of a sintered compact which comprises an aluminum nitride as the main ingredients and which contains at least one or more materials selected from a rare earth element and an alkaline-earth metal not more than 0.5 weight % in total by element conversion and contains oxygen not more than 0.9 weight %.

Item 133. The substrate for light emitting device mounting as described in Item 132, wherein the sintered compact which comprises an aluminum nitride as the main ingredients contains at least one or more materials selected from a rare earth element and an alkaline-earth metal not more than 0.2 weight % in total by element conversion and contains oxygen not more than 0.5 weight %.

Item 134. The substrate for light emitting device mounting as described in Item 132 or 133, wherein the sintered compact which comprises an aluminum nitride as the main ingredients contains at least one or more materials selected from a rare earth element and an alkaline-earth metal not more than 0.05 weight % in total by element conversion and contains oxygen not more than 0.2 weight %.

Item 135. The substrate for light emitting device mounting as described in Item 132, 133, or 134, wherein the sintered compact which comprises an aluminum nitride as the main ingredients contains at least one or more materials selected from a rare earth element and an alkaline-earth metal not more than 0.02 weight % in total by element conversion and contains oxygen not more than 0.1 weight %.

Item 136. The substrate for light emitting device mounting as described in Item 132, 133, 134, or 135, wherein the sintered compact which comprises an aluminum nitride as the main ingredients contains at least one or more compounds selected from a rare earth element and an alkaline-earth metal not more than 0.005 weight % in total by element conversion and contains oxygen not more than 0.05 weight %.

Item 137. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, or 136, and the substrate consists of a sintered compact which comprises an aluminum nitride as the main ingredients and which contains an alkaline metal and silicon not more than 0.2 weight % in total by element conversion and which contains oxygen not more than 0.9 weight %.

Item 138. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, or 137, and the substrate consists of a sintered compact which comprises an aluminum nitride as the main ingredients and which contains Mo, W, V (vanadium), Nb, Ta, Ti, and carbon not more than 0.2 weight % in total by element conversion and which contains oxygen not more than 0.9 weight %.

Item 139. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, or 138, and the substrate consists of a sintered compact which contains Fe, Ni, Co, Mn, Cr, Zr, Cu, and Zn not more than 0.2 weight % in total by element conversion and which comprises an aluminum nitride as the main ingredients and which contains oxygen not more than 0.9 weight %.

Item 140. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, or 139, and the substrate consists of a sintered compact which comprises an aluminum nitride as the main ingredients and which contains AlN not less than 95% as a crystal phase.

Item 141. The substrate for light emitting device mounting as described in Item 140, wherein the sintered compact which comprises an aluminum nitride as the main ingredients contains AlN not less than 98% as a crystal phase.

Item 142. The substrate for light emitting device mounting as described in Item 140 or 141, wherein the sintered compact which comprises an aluminum nitride as the main ingredients is a single phase of AlN substantially.

Item 143. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, or 142, and the substrate consists of a sintered compact which comprises an aluminum nitride as the main ingredients and which is thermal conductivity not less than 200 W/mK in room temperature.

Item 144. The substrate for light emitting device mounting as described in Item 143, wherein the thermal conductivity of a sintered compact which comprises an aluminum nitride as the main ingredients is not less than 220 W/mK in room temperature.

Item 145. The substrate for light emitting device mounting as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, or 144, wherein the substrate consists of a sintered compact which comprises an aluminum nitride as the main ingredients and which is relative density not less than 95%.

Item 146. The substrate for light emitting device mounting as described in Item 145, wherein the relative density of a sintered compact which comprises an aluminum nitride as the main ingredients is not less than 98%.

Item 147. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, or 146, and the substrate consists of a sintered compact which comprises an aluminum nitride as the main ingredients, and the pore in the sintered compact is an average of not more than 1 μm.

Item 148. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, or 147, and the substrate consists of a sintered compact which comprises an aluminum nitride as the main ingredients, and the size of an aluminum nitride particle in the sintered compact is an average of not less than 1 μm.

Item 149. The substrate for light emitting device mounting as described in Item 148, wherein the size of an aluminum nitride particle is an average of not less than 5 μm.

Item 150. The substrate for light emitting device mounting as described in Item 148 or 149, wherein the size of an aluminum nitride particle is an average of not less than 8 μm.

Item 151. The substrate for light emitting device mounting as described in Item 148, 149, or 150, wherein the size of an aluminum nitride particle is an average of not less than 15 μm.

Item 152. The substrate for light emitting device mounting as described in Item 148, 149, 150, or 151, wherein the size of an aluminum nitride particle is an average of not less than 25 μm.

Item 153. The substrate for light emitting device mounting as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, or 152, wherein the size of an aluminum nitride particle is an average of not more than 100 μm.

Item 154. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82,83, 84, 85, 86, 87, 88, 89, 90, 91, 92, 93, 94, 95, 96, 97, 98, 99, 100, 101, 102, 103, 104, 105, 106,107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, or 153, and the substrate consists of a sintered compact which comprises an aluminum nitride as the main ingredients, and at least one or more surfaces are the smoothness degree not more than 2000 nm as average surface roughness among surfaces of these substrates.

Item 155. The substrate for light emitting device mounting as described in Item 154, wherein among the substrate surfaces, at least one or more surfaces are the smoothness degree not more than 1000 nm as average surface roughness,

Item 156. The substrate for light emitting device mounting as described in Item 154 or 155, wherein among the substrate surfaces, at least one or more surfaces are the smoothness degree not more than 100 nm as average surface roughness.

Item 157. The substrate for light emitting device mounting as described in Item 154, 155, or 156, wherein among the substrate surfaces, at least one or more surfaces are the smoothness degree not more than 20 nm as average surface roughness.

Item 158. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, or 157, and the substrate consists of a sintered compact which comprises an aluminum nitride as the main ingredients, and at least one or more surfaces are the smoothness degree not less than 2000 nm as average surface roughness among surfaces of these substrates.

Item 159. The substrate for light emitting device mounting as described in Item 154, 155, 156, 157, or 158, wherein among the substrate surfaces, at least one or more surfaces are in at least one of states selected from the as-fire one (as-fire), lap polish, or specular surface polish.

Item 160. The substrate for light emitting device mounting as described in Item 154, 155, 156, 157, 158, or 159, wherein among the substrate surfaces, at least one or more surfaces are in the state where specular surface polish was carried out.

Item 161. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, or 160, and the substrate consists of a sintered compact which comprises an aluminum nitride as the main ingredients, and the thickness of the substrate is not more than 8.0 mm.

Item 162. The substrate for light emitting device mounting as described in Item 161, wherein the thickness of the substrate is not more than 5.0 mm.

Item 163. The substrate for light emitting device mounting as described in Item 161 or 162, wherein the thickness of the substrate is not more than 2.5 mm.

Item 164. The substrate for light emitting device mounting as described in Item 161, 162, or 163, wherein the thickness of the substrate is not more than 1.0 mm.

Item 165. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, or 164, and the substrate consists of a sintered compact which comprises an aluminum nitride as the main ingredients, and the thickness of the substrate is not less than 0.01 mm.

Item 166. The substrate for light emitting device mounting as described in Item 165, wherein the thickness of the substrate is not less than 0.02 mm.

Item 167. The substrate for light emitting device mounting as described in Item 165 or 166, wherein the thickness of the substrate is not less than 0.05 mm.

Item 168. The substrate for light emitting device mounting as described in Item 161, 162, 163, 164, 165, 166, or 167, wherein the thickness of the substrate is not more than 8.0 mm and that the optical transmissivity is not less than 1%.

Item 169. The substrate for light emitting device mounting as described in Item 161, 162, 163, 164, 165, 166, 167, or 168, wherein the thickness of the substrate is not less than 0.01 mm and that the optical transmissivity is not less than 20%.

Item 170. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, or 169, and the substrate consists of a sintered compact which comprises an aluminum nitride as the main ingredients and which has a conduction via.

Item 171. The substrate for light emitting device mounting in which a light emitting device comprises at least one or more materials selected from a gallium nitride, an indium nitride, and an aluminum nitride as the main ingredients and was described in Item 170, and the substrate consists of a sintered compact which comprises an aluminum nitride as the main ingredients and has optical permeability and which formed a conduction via.

Item 172. The substrate for light emitting device mounting as described in Item 170 or 171, wherein the conduction via comprises as the main ingredients at least one or more elements selected from gold, silver, copper, aluminum, iron, cobalt, nickel, ruthenium, rhodium, palladium, osmium, iridium, platinum, molybdenum, tungsten, chromium, titanium nitride, and zirconium nitride.

Item 173. The substrate for light emitting device mounting as described in Item 170, 171, or 172, wherein the conduction via comprises as the main ingredients at least one or more elements selected from gold, silver, copper, aluminum, iron, cobalt, nickel, ruthenium, rhodium, palladium, osmium, iridium, platinum, molybdenum, tungsten, chromium, titanium nitride, and zirconium nitride and contains further at least one or more ingredients selected from aluminum nitride, silicon carbide, silicon nitride, zinc oxide, beryllium oxide, aluminum oxide, rare earth element compound, and alkaline-earth-metals compound.

Item 174. The substrate for light emitting device mounting as described in Item 170, 171, 172, or 173, wherein the conduction via comprises as the main ingredients at least one or more elements selected from gold, silver, copper, aluminum, iron, cobalt, nickel, ruthenium, rhodium, palladium, osmium, iridium, platinum, molybdenum, tungsten, chromium, titanium nitride, and zirconium nitride and contains further at least one or more ingredients selected from aluminum nitride, silicon carbide, silicon nitride, zinc oxide, beryllium oxide, aluminum oxide, rare earth element compound, and alkaline-earth-metals compound not more than 30 weight %.

Item 175. The substrate for light emitting device mounting as described in Item 174, wherein the content of at least one or more ingredients selected from aluminum nitride, silicon carbide, silicon nitride, zinc oxide, beryllium oxide, aluminum oxide, rare earth element compound, and alkaline-earth-metals compound is not more than 20 weight % in the conduction via.

Item 176. The substrate for light emitting device mounting as described in Item 174 or 175, wherein the content of at least one or more ingredients selected from aluminum nitride, silicon carbide, silicon nitride, zinc oxide, beryllium oxide, aluminum oxide, rare earth element compound, and alkaline-earth-metals compound is not more than 10 weight % in the conduction via.

Item 177. The substrate for light emitting device mounting as described in Item 174, 175, or 176, wherein the content of at least one or more ingredients selected from aluminum nitride, silicon carbide, silicon nitride, zinc oxide, beryllium oxide, aluminum oxide, rare earth element compound, and alkaline-earth-metals compound is not more than 5 weight % in the conduction via.

Item 178. The substrate for light emitting device mounting as described in Item 170, 171, 172, 173, 174, 175, 176, or 177, wherein the conduction via comprises as the main ingredients at least one or more elements selected from gold, silver, copper, palladium, platinum, molybdenum, tungsten, titanium nitride, and zirconium nitride.

Item 179. The substrate for light emitting device mounting as described in Item 170, 171, 172, 173, 174, 175, 176, 177, or 178, wherein the conduction via comprises as the main ingredients at least one or more elements selected from gold, silver, copper, palladium, platinum, molybdenum, tungsten, titanium nitride, and zirconium nitride and contains furthermore at least one or more ingredients selected from aluminum nitride, aluminum oxide, are earth element compound, and alkaline-earth-metals compound.

Item 180. The substrate for light emitting device mounting as described in Item 170, 171, 172, 173, 174, 175, 176, 177, 178, or 179, wherein the conduction via comprises as the main ingredients at least one or more elements selected from gold, silver, copper, palladium, platinum, molybdenum, tungsten, titanium nitride, and zirconium nitride and contains furthermore at least one or more ingredients selected from aluminum nitride, aluminum oxide, rare earth element compound, and alkaline-earth-metals compound not more than 30 weight %.

Item 181. The substrate for light emitting device mounting as described in Item 180, wherein the content of at least one or more ingredients selected from an aluminum nitride, an aluminum oxide, a rare earth element compound, and an alkaline-earth-metals compound is not more than 20 weight % in the conduction via.

Item 182. The substrate for light emitting device mounting as described in Item 180 or 181, wherein the content of at least one or more ingredients selected from an aluminum nitride, an aluminum oxide, a rare earth element compound, and an alkaline-earth-metals compound is not more than 10 weight % in the conduction via.

Item 183. The substrate for light emitting device mounting as described in Item 180, 181, or 182, wherein the content of at least one or more ingredients selected from an aluminum nitride, an aluminum oxide, a rare earth element compound, and an alkaline-earth-metals compound is not more than 5 weight % in the conduction via.

Item 184. The substrate for light emitting device mounting as described in Item 170, 171, 172, 173, 174, 175, 176, 177, 178, 179, 180, 181, 182, or 183, wherein the conduction via consists of a material whose electric resistivity is not more than 1×10⁻³ Ω·cm in room temperature.

Item 185. The substrate for light emitting device mounting as described in Item 184, wherein the conduction via consists of a material whose electric resistivity is not more than 1×10⁻⁴ Ω·cm in room temperature.

Item 186. The substrate for light emitting device mounting as described in Item 184 or 185, wherein the conduction via consists of a material whose electric resistivity is not more than 5×10⁻⁵Ω·cm in room temperature.

Item 187. The substrate for light emitting device mounting as described in Item 184, 185, or 186, wherein the conduction via consists of a material whose electric resistivity is not more than 1×10⁻⁵ Ω·cm in room temperature.

Item 188. The substrate for light emitting device mounting as described in Item 170, 171, 172, 173, 174, 175, 176, 177, 178, 179, 180, 181, 182, 183, 184, 185, 186, or 187, wherein the size of a conduction via is not more than 500 μm.

Item 189. The substrate for light emitting device mounting as described in Item 188, wherein the size of a conduction via is not more than 250 μm.

Item 190. The substrate for light emitting device mounting as described in Item 188 or 189, wherein the size of a conduction via is not more than 100 μm.

Item 191. The substrate for light emitting device mounting as described in Item 188, 189, or 190, wherein the size of a conduction via is not more than 50 μm.

Item 192. The substrate for light emitting device mounting as described in Item 188, 189, 190, or 191, wherein the size of a conduction via is not more than 25 μm.

Item 193. The substrate for light emitting device mounting as described in Item 170, 171, 172, 173, 174, 175, 176, 177, 178, 179, 180, 181, 182, 183, 184, 185, 186, 187, 188, 189, 190, 191, or 192, wherein the size of a conduction via is not less than 1 μm.

Item 194. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, or 193, and the substrate consists of a sintered compact which comprises an aluminum nitride as the main ingredients and which formed an electric circuit.

Item 195. The substrate for light emitting device mounting in which a light emitting device comprises at least one or more materials selected from a gallium nitride, an indium nitride, and an aluminum nitride as the main ingredients and was described in Item 194, and the substrate consists of a sintered compact which comprises an aluminum nitride as the main ingredients and has optical permeability and which formed an electric circuit.

Item 196. The substrate for light emitting device mounting in which a light emitting device comprises at least one or more materials selected from a gallium nitride, an indium nitride, and an aluminum nitride as the main ingredients and was described in Item 194 or 195, and the substrate consists of a sintered compact which comprises an aluminum nitride as the main ingredients and which formed an electric circuit in the inside.

Item 197. The substrate for light emitting device mounting in which a light emitting device comprises at least one or more materials selected from a gallium nitride, an indium nitride, and an aluminum nitride as the main ingredients and was described in Item 194, 195, or 196, and the substrate consists of a sintered compact which comprises an aluminum nitride as the main ingredients and has optical permeability and which formed an electric circuit in the inside.

Item 198. The substrate for light emitting device mounting in which a light emitting device comprises at least one or more materials selected from a gallium nitride, an indium nitride, and an aluminum nitride as the main ingredients and was described in Item 170, 171, 172, 173, 174, 175, 176, 177, 178, 179, 180, 181, 182, 183, 184, 185, 186, 187, 188, 189, 190, 191, 192, 193, 194, 195, 196, or 197, and the substrate consists of a sintered compact which comprises an aluminum nitride as the main ingredients and which formed an electric circuit in the inside and formed a conduction via.

Item 199. The substrate for light emitting device mounting in which a light emitting device comprises at least one or more materials selected from a gallium nitride, an indium nitride, and an aluminum nitride as the main ingredients and was described in Item 194, 195, 196, 197, or 198, and the substrate consists of a sintered compact which comprises an aluminum nitride as the main ingredients and which formed an electric circuit on the surface.

Item 200. The substrate for light emitting device mounting in which a light emitting device comprises at least one or more materials selected from a gallium nitride, an indium nitride, and an aluminum nitride as the main ingredients and was described in Item 170, 171, 172, 173, 174, 175, 176, 177, 178, 179, 180, 181, 182, 183, 184, 185, 186, 187, 188, 189, 190, 191, 192, 193, 194, 195, 196, 197, 198, or 199, and the substrate consists of a sintered compact which comprises an aluminum nitride as the main ingredients and which formed an electric circuit on the surface and formed a conduction via.

Item 201. The substrate for light emitting device mounting in which a light emitting device comprises at least one or more materials selected from a gallium nitride, an indium nitride, and an aluminum nitride as the main ingredients and was described in Item 194, 195, 196, 197, 198, 199, or 200, and the substrate consists of a sintered compact which comprises an aluminum nitride as the main ingredients and which formed an electric circuit simultaneously in the inside and on the surface.

Item 202. The substrate for light emitting device mounting in which a light emitting device comprises at least one or more materials selected from a gallium nitride, an indium nitride, and an aluminum nitride as the main ingredients and was described in Item 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, or 201, and the substrate consists of a sintered compact which comprises an aluminum nitride as the main ingredients and formed a conduction via and which formed an electric circuit simultaneously in the inside and on the surface.

Item 203. The substrate for light emitting device mounting as described in Item 194, 195, 196, 197, 198, 199, 200, 201, or 202, wherein the electric circuit consists of a material which has electrical conductivity and which comprises as the main ingredients at least one or more elements selected from gold, silver, copper, aluminum, iron, cobalt, nickel, ruthenium, ruthenium oxide, rhodium, palladium, osmium, iridium, platinum, molybdenum, tungsten, chromium, titanium, zirconium, titanium nitride, zirconium nitride, tantalum nitride, and nickel chromium alloy.

Item 204. The substrate for light emitting device mounting as described in Item 194, 195, 196, 197, 198, 199, 200, 201, 202, or 203, wherein the electric circuit comprises as the main ingredients at least one or more elements selected from gold, silver, copper, aluminum, iron, cobalt, nickel, ruthenium, ruthenium oxide, rhodium, palladium, osmium, iridium, platinum, molybdenum, tungsten, chromium, titanium, zirconium, titanium nitride, zirconium nitride, tantalum nitride, and nickel chromium alloy and which contains furthermore at least one or more ingredients selected from an aluminum nitride, a silicon carbide, a silicon nitride, a zinc oxide, a beryllium oxide, an aluminum oxide, a rare earth element compound, and an alkaline-earth-metals compound.

Item 205. The substrate for light emitting device mounting as described in Item 194, 195, 196, 197, 198, 199, 200, 201, 202, 203, or 204, wherein the electric circuit comprises as the main ingredients at least one or more elements selected from gold, silver, copper, aluminum, iron, cobalt, nickel, ruthenium, ruthenium oxide, rhodium, palladium, osmium, iridium, platinum, molybdenum, tungsten, chromium, titanium, zirconium, titanium nitride, zirconium nitride, tantalum nitride, and nickel chromium alloy and which contains furthermore at least one or more ingredients selected from an aluminum nitride, a silicon carbide, a silicon nitride, a zinc oxide, a beryllium oxide, an aluminum oxide, a rare earth element compound, and an alkaline-earth-metals compound not more than 30 weight %.

Item 206. The substrate for light emitting device mounting as described in Item 205, wherein the content of at least one or more ingredients selected from an aluminum nitride, a silicon carbide, a silicon nitride, a zinc oxide, a beryllium oxide, an aluminum oxide, a rare earth element compound, and an alkaline-earth-metals compound is not more than 20 weight % in the electric circuit.

Item 207. The substrate for light emitting device mounting as described in Item 205 or 206, wherein the content of at least one or more ingredients selected from an aluminum nitride, a silicon carbide, a silicon nitride, a zinc oxide, a beryllium oxide, an aluminum oxide, a rare earth element compound, and an alkaline-earth-metals compound is not more than 10 weight % in the electric circuit.

Item 208. The substrate for light emitting device mounting as described in Item 205, 206, or 207, wherein the content of at least one or more ingredients selected from an aluminum nitride, a silicon carbide, a silicon nitride, a zinc oxide, a beryllium oxide, an aluminum oxide, a rare earth element compound, and an alkaline-earth-metals compound is not more than 5 weight % in the electric circuit.

Item 209. The substrate for light emitting device mounting as described in Item 194, 195, 196, 197, 198, 199, 200, 201, 202, 203, 204, 205, 206, 207, or 208, wherein the electric circuit was formed by co-firing a conductive material and a sintered compact which comprises an aluminum nitride as the main ingredients.

Item 210. The substrate for light emitting device mounting as described in Item 194, 195, 196, 197, 198, 199, 200, 201, 202, 203, 204, 205, 206, 207, or 208, wherein the electric circuit was formed on the once fired sintered compact which comprises an aluminum nitride as the main ingredients by printing or pasting a conductive material.

Item 211. The substrate for light emitting device mounting as described in Item 194, 195, 196, 197, 198, 199, 200, 201, 202, 203, 204, 205, 206, 207, or 208, wherein the electric circuit was formed on the sintered compact which comprises an aluminum nitride as the main ingredients as a thin film of a conductive material.

Item 212. The substrate for light emitting device mounting as described in Item 194, 195, 196, 197, 198, 199, 200, 201, 202, 203, 204, 205, 206, 207, 208, 209, 210, or 211, wherein the electric circuit is what was formed by combining at least two or more methods selected from what was formed by co-firing a conductive material and a sintered compact which comprises an aluminum nitride as the main ingredients, or what was formed on the once fired sintered compact which comprises an aluminum nitride as the main ingredients by printing or pasting a conductive material, or what was formed on the sintered compact which comprises an aluminum nitride as the main ingredients as a thin film of a conductive material.

Item 213. The substrate for light emitting device mounting as described in Item 194, 195, 196, 197, 198, 199, 200, 201, 202, 203, 204, 205, 206, 207, 208, 209, or 212, wherein the electric circuit comprises as the main ingredients at least one or more elements selected from copper, molybdenum, and tungsten and was formed by co-firing.

Item 214. The substrate for light emitting device mounting as described in Item 213, wherein the electric circuit comprises as the main ingredients at least one or more elements selected from copper, molybdenum, and tungsten and contains furthermore at least one or more materials selected from an aluminum nitride, an aluminum oxide, a rare earth element compound, and an alkaline-earth-metals compound.

Item 215. The substrate for light emitting device mounting as described in Item 214, wherein the content of at least one or more ingredients selected from an aluminum nitride, an aluminum oxide, a rare earth element compound, and an alkaline-earth-metals compound is not more than 30 weight % in the electric circuit.

Item 216. The substrate for light emitting device mounting as described in Item 194, 195, 196, 197, 198, 199, 200, 201, 202, 203, 204, 205, 206, 207, 208, 210, or 212, wherein the electric circuit consists of a conductive material that comprises as the main ingredients at least one or more elements selected from gold, silver, copper, nickel, ruthenium, ruthenium oxide, rhodium, palladium, osmium, iridium, platinum, molybdenum, and tungsten and that the conductive material is formed on the once fired sintered compact which comprises an aluminum nitride as the main ingredients by printing or pasting up.

Item 217. The substrate for light emitting device mounting as described in Item 216, wherein the electric circuit comprises as the main ingredients at least one or more elements selected from gold, silver, copper, nickel, ruthenium, ruthenium oxide, rhodium, palladium, osmium, iridium, platinum, molybdenum, and tungsten and contains furthermore at least one or more materials selected from an aluminum nitride, a silicon carbide, a silicon nitride, a zinc oxide, a beryllium oxide, an aluminum oxide, a rare earth element compound, and an alkaline-earth-metals compound.

Item 218. The substrate for light emitting device mounting as described in Item 194, 195, 196, 197, 198, 199, 200, 201, 202, 203, 204, 205, 206, 207, 208, 211, or 212, wherein the electric circuit is what was formed as a thin film which comprises as the main ingredients at least one or more elements selected from gold, silver, copper, aluminum, nickel, ruthenium, ruthenium oxide, rhodium, palladium, osmium, iridium, platinum, molybdenum, tungsten, chromium, titanium, zirconium, titanium nitride, zirconium nitride, tantalum nitride, and nickel chromium alloy.

Item 219. The substrate for light emitting device mounting as described in Item 218, wherein the electric circuit comprises as the main ingredients at least one or more elements selected from gold, silver, copper, aluminum, nickel, ruthenium, ruthenium oxide, rhodium, palladium, osmium, iridium, platinum, molybdenum, tungsten, chromium, titanium, zirconium, titanium nitride, zirconium nitride, tantalum nitride, and nickel chromium alloy and contains furthermore at least one or more materials selected from an aluminum nitride, a silicon carbide, a silicon nitride, a zinc oxide, a beryllium oxide, an aluminum oxide, a rare earth element compound, and an alkaline-earth-metals compound.

Item 220. The substrate for light emitting device mounting as described in Item 194, 195, 196, 197, 198, 199, 200, 201, 202, 203, 204, 205, 206, 207, 208, 209, 210, 211, 212, 213, 214, 215, 216, 217, 218, or 219, wherein the electric circuit is what consists of at least two or more layers which consist of a material which comprises as the main ingredients at least one or more elements selected from gold, silver, copper, aluminum, iron, cobalt, nickel, ruthenium, ruthenium oxide, rhodium, palladium, osmium, iridium, platinum, molybdenum, tungsten, chromium, titanium, zirconium, titanium nitride, zirconium nitride, tantalum nitride, and nickel chromium alloy.

Item 221. The substrate for light emitting device mounting as described in Item 220, wherein the electric circuit comprises as the main ingredients at least one or more elements selected from gold, silver, copper, aluminum, iron, cobalt, nickel, ruthenium, ruthenium oxide, rhodium, palladium, osmium, iridium, platinum, molybdenum, tungsten, chromium, titanium, zirconium, titanium nitride, zirconium nitride, tantalum nitride, and nickel chromium alloy and contains furthermore at least one or more materials selected from an aluminum nitride, a silicon carbide, a silicon nitride, a zinc oxide, a beryllium oxide, an aluminum oxide, a rare earth element compound, and an alkaline-earth-metals compound.

Item 222. The substrate for light emitting device mounting as described in Item 220 or 221, wherein the electric circuit is what consists of at least two or more layers (the layer consisting of a material which comprises as the main ingredients at least one or more elements selected from copper, molybdenum, and tungsten and was formed by co-firing, and the layer consisting of a material which comprises as the main ingredients at least one or more elements selected from gold, silver, aluminum, cobalt, nickel, palladium, and platinum).

Item 223. The substrate for light emitting device mounting as described in Item 220, 221, or 222, wherein the electric circuit is what consists of at least three or more layers which are the layer comprising at least one or more elements selected from copper, molybdenum, and tungsten as the main ingredients and being formed by co-firing, the layer comprising at least one or more materials selected from cobalt, nickel, palladium, and platinum as the main ingredients and being formed furthermore on it, and the layer comprising at least one or more elements selected from gold, silver, and aluminum as the main ingredients and forming furthermore on it.

Item 224. The substrate for light emitting device mounting as described in Item 220 or 221, wherein the electric circuit consists of at least two or more layers, the layer which formed at least one or more elements selected from silver, copper, nickel, ruthenium, ruthenium oxide, rhodium, palladium, osmium, iridium, platinum, molybdenum, and tungsten as the main ingredients by printing or pasting up onto the sintered compact comprising an aluminum nitride as the main ingredients, and the layer which formed furthermore gold as the main ingredients.

Item 225. The substrate for light emitting device mounting as described in Item 220, 221, or 224, wherein the electric circuit consists of at least two or more layers, the layer which formed at least one or more elements selected from gold, silver, copper, nickel, rhodium, palladium, osmium, iridium, platinum, molybdenum, and tungsten as the main ingredients by printing or pasting up onto the once fired sintered compact comprising an aluminum nitride as the main ingredients, and the layer which formed furthermore at least one or more materials selected from ruthenium and ruthenium oxide as the main ingredients.

Item 226. The substrate for light emitting device mounting as described in Item 220 or 221, wherein the electric circuit consists of at least two or more layers, the layer which formed as a thin film at least one or more materials selected from chromium, titanium, and zirconium as the main ingredients onto the once fired sintered compact comprising an aluminum nitride as the main ingredients, and the layer which formed furthermore as a thin film at least one or more elements selected from gold, silver, copper, aluminum, iron, cobalt, nickel, rhodium, palladium, osmium, iridium, platinum, molybdenum, tungsten, titanium nitride, zirconium nitride, tantalum nitride, and nickel chromium alloy as the main ingredients.

Item 227. The substrate for light emitting device mounting as described in Item 220, 221, or 226, wherein the electric circuit consists of at least three or more layers, the layer which formed as a thin film at least one or more materials selected from chromium, titanium, and zirconium as the main ingredients onto the once fired sintered compact comprising an aluminum nitride as the main ingredients, the layer which formed furthermore as a thin film at least one or more elements selected from iron, cobalt, nickel, rhodium, palladium, osmium, iridium, platinum, molybdenum, tungsten, titanium nitride, and zirconium nitride as the main ingredients, and the layer which formed furthermore as a thin film at least one or more elements selected from gold, silver, copper, aluminum, tantalum nitride, and nickel chromium alloy as the main ingredients.

Item 228. The substrate for light emitting device mounting as described in Item 220, 221, 226, or 227, wherein the electric circuit consists of at least four or more layers, the layer which formed as a thin film at least one or more materials selected from chromium, titanium, and zirconium as the main ingredients onto the once fired sintered compact comprising an aluminum nitride as the main ingredients, the layer which formed furthermore as a thin film at least one or more elements selected from iron, cobalt, nickel, rhodium, palladium, osmium, iridium, platinum, molybdenum, tungsten, titanium nitride, and zirconium nitride as the main ingredients, the layer which formed furthermore as a thin film at least one or more elements selected from gold, silver, copper, and aluminum as the main ingredients, and the layer which formed furthermore as a thin film at least one or more materials selected from tantalum nitride and nickel chromium alloy as the main ingredients.

Item 229. The substrate for light emitting device mounting as described in Item 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, or 228, wherein the electric circuit consists of the conductive material whose electric resistivity is not more than 1×10⁻³ Ω·cm in room temperature.

Item 230. The substrate for light emitting device mounting as described in Item 229, wherein the electric circuit consists of a conductive material whose electric resistivity is not more than 1×10⁻⁴ Ω·cm in room temperature.

Item 231. The substrate for light emitting device mounting as described in Item 229 or 230, wherein the electric circuit consists of a conductive material whose electric resistivity is not more than 5×10⁻⁵ Ω·cm in room temperature.

Item 232. The substrate for light emitting device mounting as described in Item 229, 230, or 231, wherein the electric circuit consists of a conductive material whose electric resistivity is not more than 1×10⁻⁵ Ω·cm in room temperature.

Item 233. The substrate for light emitting device mounting as described in Item 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, or 232, wherein an electric circuit is one of what functions as supplier of an electric signal and an electric power in order to drive a light emitting device which comprises as the main ingredients at least one or more materials selected from a gallium nitride, an indium nitride, and an aluminum nitride, or what functions as metallizing in order to fix a light emitting device to a substrate, or what functions as supplier of an an electric signal and an electric power in order to drive a light emitting device and functions as metallizing in order to fix a light emitting device to a substrate.

Item 234. The substrate for light emitting device mounting as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, or 233, wherein the substrate for light emitting device mounting consists of a board-like sintered compact which comprises a aluminum nitride as the main ingredients.

Item 235. The substrate for light emitting device mounting as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210,211, 212, 213, 214, 215, 216, 217, 218, 219, 220, 221, 222, 223, 224, 225, 226, 227, 228, 229, 230, 231, 232, 233, or 234, wherein the substrate for light emitting device mounting consists of a sintered compact which comprises an aluminum nitride as the main ingredients and which has cavity space.

Item 236. The substrate for light emitting device mounting as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136,137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, or 235, wherein the substrate for light emitting device mounting has cavity space and that the lid attached in order to seal this cavity space consists of a sintered compact which comprises an aluminum nitride as the main ingredients.

Item 237. The substrate for light emitting device mounting as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210,211, 212, 213, 214, 215, 216, 217, 218, 219, 220, 221, 222, 223, 224, 225, 226, 227, 228, 229, 230, 231, 232, 233, 234, 235, or 236, wherein the substrate for light emitting device mounting is assembled by junction of a base and a frame and that any one or more of this base and frame consists of a sintered compact which comprises an aluminum nitride as the main ingredients.

Item 238. The substrate for light emitting device mounting as described in Item 237, wherein in the substrate for light emitting device mounting assembled by junction of a base and a frame, the adhesive which comprises silicone resin as the main ingredients is used for junction of this base and frame.

Item 239. The substrate for light emitting device mounting as described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, or 238, wherein the substrate for light emitting device mounting consists of an united sintered compact which comprises an aluminum nitride as the main ingredients.

Item 240. The substrate for light emitting device mounting as described in Item 234, 235, 236, 237, 238, or 239, wherein the sintered compact which comprises an aluminum nitride as the main ingredients has optical permeability.

Item 241. The substrate for light emitting device mounting in which a light emitting device comprises at least one or more materials selected from a gallium nitride, an indium nitride, and an aluminum nitride as the main ingredients and was described in Item 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210,211, 212, 213, 214, 215, 216, 217, 218, 219, 220, 221, 222, 223, 224, 225, 226, 227, 228, 229, 230, 231, 232, 233, 234, 235, 236, 237, 238, 239, or 240, and the substrate consists of a sintered compact which comprises an aluminum nitride as the main ingredients, and the substrate is able to mount two or more light emitting devices.

Item 242. A manufacture method of the substrate for light emitting device mounting in which a light emitting device comprises at least one or more materials selected from a gallium nitride, an indium nitride, and an aluminum nitride as the main ingredients, and the substrate consists of a sintered compact which comprises an aluminum nitride as the main ingredients, the method comprises using as a raw material at least one of raw materials using respectively alone of either which is selected from what is made by reduction of an aluminum oxide and what is made by direct nitriding of metal aluminum, or using the mixture of what is made by reduction of an aluminum oxide and what is made by direct nitriding of metal aluminum, to form the sintered compact.

Item 243. A manufacture method of the substrate for light emitting device mounting in which a light emitting device comprises at least one or more materials selected from a gallium nitride, an indium nitride, and an aluminum nitride as the main ingredients, and the substrate consists of a sintered compact which comprises an aluminum nitride as the main ingredients, the method comprises firing the powder compact or sintered compact which comprise an aluminum nitride as the main ingredients for not less than 10 minutes at the temperature not less than 1500 degrees C. in non-oxidizing atmosphere to form the sintered compact.

Item 244. The manufacture method of the substrate for light emitting device mounting in which a light emitting device comprises at least one or more materials selected from a gallium nitride, an indium nitride, and an aluminum nitride as the main ingredients and was described in Item 242 or 243, and the substrate consists of a sintered compact which comprises an aluminum nitride as the main ingredients and is obtained by firing the powder compact or sintered compact which comprise an aluminum nitride as the main ingredients and is manufactured by using as a raw material at least one of raw materials using respectively alone of either which is selected from what is made by reduction of an aluminum oxide and what is made by direct nitriding of metal aluminum, or by using the mixture of what is made by reduction of an aluminum oxide and what is made by direct nitriding of metal aluminum, at the temperature not less than 1500 degrees C. for not less than 10 minutes in a non-oxidizing atmosphere.

Item 245. The manufacture method of the substrate for light emitting device mounting as described in Item 242, 243, or 244, wherein the sintered compact which comprises an aluminum nitride as the main ingredients has optical permeability.

Item 246. The manufacture method of the substrate for light emitting device mounting as described in Item 242, 243, 244, or 245, wherein the sintered compact which comprises an aluminum nitride as the main ingredients has the optical transmissivity not less than 1%.

Item 247. The manufacture method of the substrate for light emitting device mounting as described in Item 246, wherein the sintered compact which comprises an aluminum nitride as the main ingredients has the optical transmissivity not less than 5%.

Item 248. The manufacture method of the substrate for light emitting device mounting as described in Item 246 or 247, wherein the sintered compact which comprises an aluminum nitride as the main ingredients has the optical transmissivity not less than 10%.

Item 249. The manufacture method of the substrate for light emitting device mounting as described in Item 246, 247, or 248, wherein the sintered compact which comprises an aluminum nitride as the main ingredients has the optical transmissivity not less than 20%.

Item 250. The manufacture method of the substrate for light emitting device mounting as described in Item 246, 247, 248, or 249, wherein the sintered compact which comprises an aluminum nitride as the main ingredients has the optical transmissivity not less than 30%.

Item 251. The manufacture method of the substrate for light emitting device mounting as described in Item 246, 247, 248, 249, or 250, wherein the sintered compact which comprises an aluminum nitride as the main ingredients has the optical transmissivity not less than 40%.

Item 252. The manufacture method of the substrate for light emitting device mounting as described in Item 246, 247, 248, 249, 250, or 251, wherein the sintered compact which comprises an aluminum nitride as the main ingredients has the optical transmissivity not less than 50%.

Item 253. The manufacture method of the substrate for light emitting device mounting as described in Item 246, 247, 248, 249, 250, 251, or 252, wherein the sintered compact which comprises an aluminum nitride as the main ingredients has the optical transmissivity not less than 60%.

Item 254. The manufacture method of the substrate for light emitting device mounting as described in Item 246, 247, 248, 249, 250, 251, 252, or 253, wherein the sintered compact which comprises an aluminum nitride as the main ingredients has the optical transmissivity not less than 80%.

Item 255. The manufacture method of the substrate for light emitting device mounting as described in Item 246, 247, 248, 249, 250, 251, 252, 253, or 254, wherein the sintered compact which comprises an aluminum nitride as the main ingredients has the optical transmissivity not less than 85%.

Item 256. The manufacture method of the substrate for light emitting device mounting as described in Item 242, 243, 244, 245, 246, 247, 248, 249, 250, 251, 252, 253, 254, or 255 which is characterized by consisting of a sintered compact which comprises an aluminum nitride as the main ingredients and which is obtained by firing the powder compact or sintered compact which comprise an aluminum nitride as the main ingredients at the firing temperature not less than 1500 degrees C. for not less than 10 minutes in non-oxidizing atmosphere containing an aluminum nitride ingredient.

Item 257. The manufacture method of the substrate for light emitting device mounting as described in Item 256 which is characterized by consisting of a sintered compact which comprises an aluminum nitride as the main ingredients and which is obtained by supplying an aluminum nitride ingredient into the non-oxidizing atmosphere which is a firing atmosphere from the powder compact or sintered compact which comprise an aluminum nitride as the main ingredients and are a fired thing, and by firing the fired thing at the temperature not less than 1500 degrees C. for not less than 10 minutes in this non-oxidizing atmosphere.

Item 258. The manufacture method of the substrate for light emitting device mounting as described in Item 256 which is characterized by consisting of a sintered compact which comprises an aluminum nitride as the main ingredients and which is obtained by supplying an aluminum nitride ingredient into the non-oxidizing atmosphere which is a firing atmosphere from except the powder compact or sintered compact which comprise an aluminum nitride as the main ingredients and are a fired thing, and by firing the fired thing at the temperature not less than 1500 degrees C. for not less than 10 minutes in this non-oxidizing atmosphere.

Item 259. The manufacture method of the substrate for light emitting device mounting as described in Item 256 or 258, wherein the powder compact or sintered compact which comprise an aluminum nitride as the main ingredients are fired using the firing container or firing implement which consist of a material which comprises an aluminum nitride as the main ingredients.

Item 260. The manufacture method of the substrate for light emitting device mounting as described in Item 258 or 259, wherein the powder compact or sintered compact which comprise an aluminum nitride as the main ingredients and are a fired thing are fired by co-existing of at least one or more things selected from the powder which comprises an aluminum nitride as the main ingredients, or the powder compact which comprises an aluminum nitride as the main ingredients, or the sintered compact which comprises an aluminum nitride as the main ingredients other than these fired thing in a firing container or a firing implement.

Item 261. The manufacture method of the substrate for light emitting device mounting as described in Item 256, 257, 258, 259, or 260, wherein the powder compact or sintered compact which comprise an aluminum nitride as the main ingredients are fired using the firing container or firing implement which consist of at least one or more materials selected from aluminum nitride, tungsten, molybdenum, boron nitride, and carbon which coated a boron nitride as the main ingredients.

Item 262. The manufacture method of the substrate for light emitting device mounting as described in Item 242, 243, 244, 245, 246, 247, 248, 249, 250, 251, 252, 253, 254, 255, 256, 257, 258, 259, 260, or 261, wherein a powder compact which comprises an aluminum nitride as the main ingredients is made into the sintered compact which comprises an aluminum nitride as the main ingredients by once firing and that the sintered compact is fired under pressure by the hot press method or the hot isostatic press (HIP) method.

Item 263. The manufacture method of the substrate for light emitting device mounting in which a light emitting device comprises at least one or more materials selected from a gallium nitride, an indium nitride, and an aluminum nitride as the main ingredients and was described in Item 242, 243, 244, 245, 246, 247, 248, 249, 250, 251, 252, 253, 254, 255, 256, 257, 258, 259, 260, 261, or 262, and the substrate is a thing which heats the powder compacr or sintered compact which comprise an aluminum nitride as the main ingredients at the temperature not less than 1750 degrees C. for not less than 3 hours in non-oxidizing atmosphere.

Item 264. The manufacture method of the substrate for light emitting device mounting in which a light emitting device comprises at least one or more materials selected from a gallium nitride, an indium nitride, and an aluminum nitride as the main ingredients and was described in Item 242, 243, 244, 245, 246, 247, 248, 249, 250, 251, 252, 253, 254, 255, 256, 257, 258, 259, 260, 261, 262, or 263, and the substrate consists of a sintered compact which comprises an aluminum nitride as the main ingredients and which is obtained by making at least one or more ingredients selected from at least a rare earth element compound, an alkaline-earth-metals compound, and oxygen among the ingredients contained vaporize, remove, and decrease by firing the powder compact or sintered compact which comprise an aluminum nitride as the main ingredients and which contain at least one or more compounds selected from a rare earth element compound and an alkaline-earth-metals compound at the temperature not less than 1750 degrees C. for not less than 3 hours in non-oxidizing atmosphere.

Item 265. The manufacture method of the substrate for light emitting device mounting as described in Item 263 or 264, wherein the firing temperature is not less than 1900 degrees C.

Item 266. The manufacture method of the substrate for light emitting device mounting as described in Item 263, 264, or 265, wherein the firing temperature is not less than 2050 degrees C.

Item 267. The manufacture method of the substrate for light emitting device mounting as described in Item 263, 264, 265, or 266, wherein the firing temperature is not less than 2100 degrees C.

Item 268. The manufacture method of the substrate for light emitting device mounting in which a light emitting device comprises at least one or more materials selected from a gallium nitride, an indium nitride, and an aluminum nitride as the main ingredients and was described in Item 242, 243, 244, 245, 246, 247, 248, 249, 250, 251, 252, 253, 254, 255, 256, 257, 258, 259, 260, 261, 262, 263, 264, 265, 266, or 267, and the substrate consists of a sintered compact which comprises an aluminum nitride as the main ingredients and which is obtained by making at least one or more ingredients selected from at least a rare earth element compound, an alkaline-earth-metals compound, and oxygen among the ingredients contained vaporize, remove, and decrease by firing the powder compact or sintered compact which comprise an aluminum nitride as the main ingredients and which contain simultaneously at least one or more compounds selected from a rare earth element compound and an alkaline-earth-metals compound at the temperature not less than 1750 degrees C. for not less than 3 hours in non-oxidizing atmosphere.

Item 269. The manufacture method of the substrate for light emitting device mounting in which the substrate for thin film formation consists of a sintered compact which comprises an aluminum nitride as the main ingredients and which is obtained by firing the powder compact comprising an aluminum nitride as the main ingredients, as described in Item 242, 243, 244, 245, 246, 247, 248, 249, 250, 251, 252, 253, 254, 255, 256, 257, 258, 259, 260, 261, 262, 263, 264, 265, 266, 267, or 268, wherein the powder compact consists of a green sheet comprising an aluminum nitride raw material powder as the main ingredients, in the manufacture method of the substrate for mounting a light emitting device which comprises as the main ingredients at least one or more materials selected from a gallium nitride, an indium nitride, and an aluminum nitride.

Item 270. The manufacture method of the substrate for light emitting device mounting in which the substrate for thin film formation consists of a sintered compact which comprises an aluminum nitride as the main ingredients and which is obtained by firing furthermore the sintered compact obtained by firing the powder compact comprising an aluminum nitride as the main ingredients, as described in Item 242, 243, 244, 245, 246, 247, 248, 249, 250, 251, 252, 253, 254, 255, 256, 257, 258, 259, 260, 261, 262, 263, 264, 265, 266, 267, 268, or 269, wherein the powder compact consists of a green sheet comprising an aluminum nitride raw material powder as the main ingredients, in the manufacture method of the substrate for mounting a light emitting device which comprises as the main ingredients at least one or more materials selected from a gallium nitride, an indium nitride, and an aluminum nitride.

Item 271. The manufacture method of the substrate for light emitting device mounting as described in Item 242, 243, 244, 245, 246, 247, 248, 249, 250, 251, 252, 253, 254, 255, 256, 257, 258, 259, 260, 261, 262, 263, 264, 265, 266, 267, 268, 269, or 270, wherein the firing is performed at the temperature not less than 1750 degrees C. for not less than 10 hours.

Item 272. The manufacture method of the substrate for light emitting device mounting as described in Item 242, 243, 244, 245, 246, 247, 248, 249, 250, 251, 252, 253, 254, 255, 256, 257, 258, 259, 260, 261, 262, 263, 264, 265, 266, 267, 268, 269, 270, or 271, wherein the firing is performed at the temperature not less than 1900 degrees C. for not less than 6 hours.

Item 273. The manufacture method of the substrate for light emitting device mounting as described in Item 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, or 272, wherein the firing is performed at the temperature not less than 2050 degrees C. for not less than 4 hours. Item 274. The manufacture method of the substrate for light emitting device mounting as described in Item 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, or 273, wherein the firing is performed at the temperature not less than 2100 degrees C. for not less than 3 hours.

Item 275. The manufacture method of the substrate for light emitting device mounting as described in Item 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, or 274, wherein the firing atmosphere contains at least one or more elements selected from nitrogen, helium, neon, and argon.

Item 276. The manufacture method of the substrate for light emitting device mounting as described in Item 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, or 275, wherein the firing atmosphere is a reduced atmosphere.

Item 277. The manufacture method of the substrate for light emitting device mounting as described in Item 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, or 276, wherein the firing atmosphere contains at least one or more elements selected from hydrogen, carbon, carbon monoxide, and hydrocarbon.

Item 278. The manufacture method of the substrate for light emitting device mounting as described in Item 275, 276, or 277, wherein the firing atmosphere contains at least one or more elements selected from hydrogen, carbon, carbon monoxide, and hydrocarbon not less than 0.1 ppm.

Item 279. The manufacture method of the substrate for light emitting device mounting as described in Item 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, or 278, wherein the minimum size of the fired powder compact or sintered compact which comprise an aluminum nitride as the main ingredients is not more than 8 mm.

Item 280. The manufacture method of the substrate for light emitting device mounting as described in Item 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, or 279, wherein the fired powder compact or sintered compact which comprise an aluminum nitride as the main ingredients are board-like and that the thickness is not more than 8 mm.

### INDUSTRIAL APPLICATION

According to this invention, it was shown that the single crystal thin film which comprises as the main ingredients at least one or more materials selected from a gallium nitride, an indium nitride, and an aluminum nitride, or the thin film of various crystallized states can form on the substrate which consists of a sintered compact which comprises an aluminum nitride as the main ingredients, or on the substrate which consists of various sintered compacts which comprise a ceramic material as the main ingredients.

This single crystal thin film has high crystallinity of the grade which can be used for a part of light emitting device or for an optical waveguide.

As for such a substrate which consists of a sintered compact which comprises an aluminum nitride as the main ingredients, a substrate which consists of various sintered compacts which comprise a ceramic material as the main ingredients, and a thin film substrate which formed the single crystal thin film or the thin film of various crystallized states onto these substrates, even if which substrate is used, production of a light emitting device which consists of a nitride semiconductor that comprises as the main ingredients at least one or more materials selected from a gallium nitride, an indium nitride, and an aluminum nitride was attained on it.

As compared with the conventional light emitting device produced using single crystal substrates, such as sapphire, the luminous efficiency of this light emitting device is equivalent at least, or has improved greatly with a maximum of not less than 4-5 times.

An optical waveguide which can transmit ultraviolet light in low loss can be produced now using the thin film which comprises an aluminum nitride as the main ingredients and was formed on the substrate which consists of a sintered compact which comprises an aluminum nitride as the main ingredients.

Thus, according to this invention, as for the substrate which consists of various ceramic materials including the sintered compact which comprises an aluminum nitride as the main ingredients, and the thin film substrate on which the single crystal thin film that comprises as the main ingredients at least one or more materials selected from a gallium nitride, an indium nitride, and an aluminum nitride, or the thin film of various crystallized states was formed on this substrate, since they can be applied for extensive uses, such as a display which formed the thin film as a field emission material, a surface acoustic emission device, or a circuit substrate other than the above light emitting device or optical waveguide, the effect which gives to industry is large.

It is as follows as summarizing the effect in the case of manufacturing a light emitting device using the substrate according to this invention.

A) Since the crystallinity of the single crystal thin film which is formed on a substrate and which comprises as the main ingredients at least one or more materials selected from a gallium nitride, an indium nitride, and an aluminum nitride is high, the luminous efficiency of a light emitting device increases.

B) The crystal direction of the single crystal thin film which is formed on a substrate and which comprises as the main ingredients at least one or more materials selected from a gallium nitride, an indium nitride, and an aluminum nitride is controllable.

C) A substrate with high optical transmissivity can be used, the light from light emitting device can emit to the device exterior efficiently without being little absorbed by the substrate, and the luminous efficiency of a light emitting device improves.

D) Since the thermal conductivity of a substrate is high, high electric power can be impressed to a light emitting device, and the luminescence output of a light emitting device can be heightened.

E) Generating dislocation and crack etc. by the difference of thermal expansion coefficient decreases in the single crystal thin film because the thermal expansion coefficient of a substrate is close to the single crystal thin film which comprises as the main ingredients at least one or more materials selected from a gallium nitride, an indium nitride, and an aluminum nitride, and the luminous efficiency of a light emitting device increases.

F) The conduction via for connecting an up-and-down surface electrically can be provided to a substrate, and since the conductive sintered compact which comprises a zinc oxide as the main ingredients can be used as a substrate furthermore, P and N electrode of a light emitting device can be arranged not only in one surface of a device but also in the up-and-down surface of a device.

Therefore, in order to form an electrode, it is not necessary to etch a part of device, and an device can be produced as it is only by cutting a substrate, a manufacturing process is simplified, moreover, danger of the damage of the device which is easy to produce while etching decreases.

G) The luminous efficiency of the light emitting device which consists of a nitride semiconductor that comprises as the main ingredients at least one or more materials selected from a gallium nitride, an indium nitride, and an aluminum nitride is equivalent at least to the thing using conventional single crystal substrates, such as sapphire, or improves to a maximum of not less than 4-5 times, moreover, since a substrate is the sintered compact which comprises a ceramic material as the main ingredients, it can manufacture in cheap cost than the thing which uses conventional single crystal substrates, such as sapphire.

Moreover, if the sintered compact which comprises an aluminum nitride as the main ingredients and which has optical permeability, or the sintered compact which comprises an aluminum nitride as the main ingredients and which formed the reflective prevention material and the reflective material is used as a substrate for light emitting device mounting, luminescence from the light emitting device mounted on the substrate is efficiently emitted to the substrate exterior, and the direction of luminescence emitted to the substrate exterior is controllable.

Moreover, since this substrate consists of a polycrystalline substance having optical permeability, luminescence from the light emitting device which penetrates a substrate and is emitted to the substrate exterior tends to turn into a scattered light, and it has the feature which is different from the light which penetrated transparent glass, resin, etc. linearly and has brightness which pierces the eye, it is quiet and is easy to become a light gentle to man's eyes.

Since this substrate is a sintered compact, it is simple and cheap, it is applicable to a wide range use, and the influence which gives to industry is large.

1. A substrate for thin film formation in which a thin film comprises at least one or more materials selected from the group consisting of a gallium nitride, an indium nitride, and an aluminum nitride as the main ingredient(s) and the substrate consists of a sintered compact which comprises an aluminum nitride as the main ingredient.

2. A substrate for thin film formation in which a thin film comprises at least one or more materials selected from the group consisting of a gallium nitride, an indium nitride, and an aluminum nitride as the main ingredients, and the substrate consists of a sintered compact which comprises as the main ingredient a ceramic material which has at least one of the crystal structures selected from a hexagonal system or a trigonal system.

3. A substrate for thin film formation in which a thin film comprises at least one or more materials selected from the group consisting of a gallium nitride, an indium nitride, and an aluminum nitride as the main ingredient(s), and the substrate consists of a sintered compact which comprises a ceramic material as the main ingredient and which has optical permeability.

4-25. (canceled)
